(19) United States
(12) Patent Application Publication
(10) Pub. No.: US 2016/0170859 A1
(43) Pub. Date: Jun. 16, 2016

(54) GENERATING AND UTILIZING FINITE INPUT OUTPUT MODELS, COMPARISON OF SEMANTIC MODELS AND SOFTWARE QUALITY ASSURANCE

(71) Applicant: PHASE CHANGE SOFTWARE LLC, Golden, CO (US)

(72) Inventor: Steven BUCUVALAS, Golden, CO (US)

(21) Appl. No.: 15/044,728

(22) Filed: Feb. 16, 2016

Related U.S. Application Data
(62) Division of application No. 11/693,491, filed on Mar. 29, 2007, now abandoned.
(60) Provisional application No. 60/895,837, filed on Mar. 20, 2007.
(60) Provisional application No. 60/887,494, filed on Jan. 31, 2007.
(60) Provisional application No. 60/869,372, filed on Dec. 11, 2006.
(60) Provisional application No. 60/800,279, filed on May 12, 2006.

(51) Int. Cl. G06F 11/36; G06F 9/45

(52) U.S. Cl. CPC G06F 11/3608; G06F 11/3612; G06F 8/427

(57) ABSTRACT

Aspects of the invention relate generally to software, and more specifically to one or more specifically to software development, FIOSM creation, comparison and subsumption in a software environment and software quality assurance. An exemplary embodiment includes the processes of: (i) designing and verifying that a computer language can completely and correctly generate a Finite Input-Output Semantic Model (FIOSM); and (ii) generating, typically using automation, a FIOSM for a program or system of several programs written in a FIOSM-compatible language.

### RELATED APPLICATION DATA

This application claims the benefit of and priority under 35 U.S.C. §119(e) to U.S. Provisional Application No. 60/800,279 filed May 12, 2006, U.S. Provisional Application No. 60/869,372 filed Dec. 11, 2006, U.S. Provisional Application No. 60/887,494 filed Jan. 31, 2007, and U.S. Provisional Application No. 60/895,837, filed Mar. 20, 2007, all of which are incorporated herein by reference in their entirety.

### BACKGROUND

1. Field of the Invention

An exemplary embodiment of this invention relates generally to software, and more specifically to one or more of software development, comparison and subsumption in a software development environment and software quality assurance.

2. Description of Related Art

Computers have revolutionized many business functions in the last forty years, but developing the software for these business systems remains a vexing problem for business leadership.

The development of major business systems is typically called Enterprise Software Development (ESD) and remains a costly, slow, error-prone, and risky venture for business. “Business” in this context means industries outside the Information Technology (IT) industry, but whose infrastructure is heavily dependent on Information Technology. Examples of such industries are Health Services, Financial Services, Insurance, and Transportation.

The high cost of Enterprise Software Development stems from the labor-intensive nature of the process. The core activities of analysis, programming, and quality assurance require a highly educated, professional staff. These core activities are intensely intellectual and abstract. The size and complexity of the projects requires large staff and many specialized roles, including (but not limited to): business analysts, project managers, technical analysts, software designers, database administrators, and programmers.

These large projects are prone to failure and those that are successful are expensive and slow to market. With the large staff and differing roles, an enormous effort must be made to communicate to all involved, coordinating the esoteric and intricate activities. This communication effort increases the overhead enormously and results in a startling decreases in productivity as project size increases as is indicated in prior art FIG. 1.

FIG. 1 is a diagram adapted from Applied Software Measurement (McGraw-Hill, 1996) by Caper Jones, which is incorporated by reference herein. As the number of function points (as indicated in the horizontal axis 12) required in an enterprise software development task increases, the relative productivity (as indicated by the vertical axis 14) of each programmer involved with the project decreases.

The decrease in productivity and the resulting protracted delivery schedules often cause the projects to be outstripped by changes in the business environment; they in essence become obsolete before delivery. This fact results in a high incidence of project cancellation. Approximately 20% of Enterprise projects are cancelled before delivery. This results in a total loss of investment made by business; and increases, even more, the average cost of such projects to business.

The quality associated with these large scale Enterprise software projects is relatively low, and there is an equally startling decrease of quality per unit of software written as project increases in size to the Enterprise level as shown in prior art FIG. 2. These errors (“bugs”) compromise a large company's ability to deliver quality service to their customers.

FIG. 2 is also a diagram adapted from Applied Software Measurement by Caper Jones. As the number of function points (as indicated in the horizontal axis 16) required in an enterprise software development task increases, the relative error rate per function point (as indicated by the vertical axis 18) of each programmer involved with the project increases. The fundamental problem with ESD is that the core activities have resisted computer automation. Software, by its nature, requires human inspection and analysis.

It is a truism that all major activities associated with the development of Enterprise systems require people to be able to analyze the algorithmic procedures which comprise software: (i) programmers are needed to analyze procedural specifications and to write software code; (ii) software designers are needed to analyze the procedures to structure the software components effectively; (iii) database administrators are needed to analyze the procedures to determine how relational tables should be structured; and (iv) quality assurance analysts are needed to understand how the procedures behave in order to build test cases. Similarly, all professional roles are required to have a procedural understanding of software in order to fulfill their core activities.

The challenge of computer automation in these core activities stems from the fact that software cannot be reliably analyzed by computers. In 1936, the British mathematician Alan Turing proved that software procedures are beyond reliable analysis by other computing systems. This proof (also known as the ‘Halting Problem”) demarked a clear barrier to automation of the analytical activities associated with ESD. For additional information on the Halting Problem, see Lewis, R. Elements of a Theory of Computation. New Jersey: Prentice-Hall, 1981, p. 272 which is incorporated by reference herein.

Whereas computer procedures (algorithms) were proven to be beyond the structured analysis of other computers, human labor using human reasoning can analyze software “approximately.” This “approximate” understanding is sufficient to allow the development and analysis of software, but at high expense, relatively low quality, and slow time to market.

Since outright automation has not been possible, the Information Technology (IT) industry has focused on the development of methodologies and tools that attempt to make ESD incrementally better.

Over the last fifty years the industry has developed “process methodologies” such as “Structured Development,” Waterfall Development,” “RAD Development,” and most recently “Agile Development.” These methodologies are increasingly more refined attempts to manage the vexing management and coordination of the activities associated with large ESD projects.

Programmers now use Integrated-Development-Environments (IDEs) for the development of program procedures. Software Designers and Database administrators use graphical tools to develop “Object” and database structure.

The industry has used information technology to share information more effectively: using intranet websites to share analysis documents, using specialized databases to track quality issues and change requests, etc.

In summary, the IT industry has attempted repeatedly to instill an engineering discipline upon the ESD process with limited success. See Gibbs, W. “Software's Chronic Crisis” Scientific American. September, 1994, p. 86, which is incorporated by reference herein. These measures have incrementally improved ESD, but not to the satisfaction of leadership either in business or IT industries.

For Business Leadership, when considering Enterprise Development, the problems of cost, quality, and time-to-market remain unresolved. To this leadership, the problem has not improved substantially or in pace with other areas of technology.

Enterprise Development remains an area where Business Leadership still actively searches for the break-through that alleviates the fundamental problems of ESD.

### SUMMARY

Non-limiting exemplary aspects of the invention are directed toward:

1. A method for quality control of software comprising:
generating a parse tree;
generating a code path set based on the parse tree;
generating a path data model set using the code path set; and
generating a finite input/output semantic model (FIOSM) from the path data model set.

2. The method of aspect 1, wherein the generation of a finite input/output semantic model dictates that the software has a completely decidable data flow.

3. The method of aspect 1 wherein said generating a parse tree comprises parsing the source code of a software procedure.

4. The method of aspect 1 wherein said generating a parse tree comprises parsing the source code of a software program.

5. The method of aspect 1 wherein the parse tree comprises a directed acyclic graph structure (DAG).

6. The method of aspect 3, wherein the source code is written in a FIOSM compliant programming language.

7. The method of aspect 4, wherein the source code is written in a FIOSM compliant programming language.

8. The method of aspect 1, wherein said generating a code path set based on the parse tree comprises utilizing a suitable algorithm to walk the parse tree.

9. The method of aspect 1, wherein the code path set comprises condition free code path trees.

10. The method of aspect 8, wherein the suitable algorithm comprises a tableau algorithm.

11. The method of aspect 8, wherein the suitable algorithm comprises a book-marking algorithm.

12. The method of aspect 1, wherein the path data model set comprises a plurality of logically consistent data element models.

13. The method of aspect 12, wherein said generating a path data model set using the code path set includes discarding any logically inconsistent data element models.

14. The method of aspect 1, wherein said generating a path data model set using the code path set comprises for each code path set element: (i) walking the code path parse tree of the code path set element; (ii) recording assignments and constraints for the code path set element.

15. The method of aspect 1, wherein said generating a path data model set using the code path set comprises converting the code path set into a set of logically consistent data model elements.

16. The method of aspect 1, wherein said generating a finite input/output semantic model (FIOSM) from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

17. The method of aspect 16, wherein said formatting a FIOSM from the path data model set further comprises: eliminating intermediate data elements.

18. A method comprising:
providing a software program written in a finite input-output semantic model (FIOSM) compliant language; and
generating a FIOSM for the software program.

19. The method of aspect 18, wherein the FIOSM compliant language comprises a modified version of an existing language.

20. The method of aspect 18, wherein the existing language is one of C, C+, C++, Java, Basic, Pascal, and Fortran.

21. The method of aspect 18, further comprising creating a FIOSM compliant language.

22. The method of aspect 18, further comprising modifying an existing computer language to be a FIOSM compliant language.

23. The method of aspect 18, further comprising modifying an existing non-FIOSM compliant computer language to be the FIOSM compliant language.

24. The method of aspect 18, wherein the FIOSM compliant language does not include operators having ambiguous semantics.

25. The method of aspect 18, wherein the FIOSM compliant language does not include operators capable of invoking infinite code paths.

26. The method of aspect 24, wherein the FIOSM compliant language does not include operators capable of invoking infinite code paths.

27. The method of aspect 18 wherein the software program does not include operators having ambiguous semantics or control flow operators capable of invoking infinite code paths.

28. The method of aspect 18 wherein the software program includes a plurality of operators wherein no combination of operators of the plurality of operators are capable of invoking an infinite code path in the computer program.

29. The method of aspect 18 wherein the software program comprises at least 1,000 lines.

30. The method of aspect 18 wherein the software program comprises at least 10,000 lines.

31. The method of aspect 18 wherein the software program comprises at least 100,000 lines.

32. The method of aspect 18 wherein the software program comprises at least 1,000,000 lines.

33. The method of aspect 18, wherein said generating a FIOSM further comprises:
parsing the source code of the program to generate a parse tree;
generating a code path set using the parse tree;
generating a path data model set using the code path set; and
formatting a FIOSM from the path data model set.

34. The method of aspect 18, wherein the FIOSM consists of all possible inputs to the software program and all possible outputs the software program can generate based on all possible inputs.

35. The method of aspect 33, wherein the parse tree comprises a directed acyclic graph structure (DAG).

36. The method of aspect 33, wherein the parse tree comprises a directed acyclic graph structure (DAG).

37. The method of aspect 33, wherein the parse tree comprises a tree model.

38. The method of aspect 33 wherein said generating code path sets using the parse tree comprises utilizing a suitable algorithm to walk the parse tree.

39. The method of aspect 38 wherein the suitable algorithm comprises a tableau algorithm.

40. The method of aspect 38 wherein the suitable algorithm comprises a model search algorithm.

41. The method of aspect 33 wherein the path data model set comprises a plurality of logically consistent data element models.

42. The method of aspect 38 wherein said generating a path data model set using the code path set includes discarding any logically inconsistent data element models.

43. The method of aspect 33 wherein said generating a path data model set using the code path sets comprises for each code path set element: (i) walking the code path parse tree of the code path set element; (ii) recording assignments and constraints for the code path set element.

44. The method of aspect 33 wherein said formatting a FIOSM from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

45. The method of aspect 44, wherein said formatting a FIOSM from the path data model set further comprises: eliminating intermediate data elements.

46. A method of software engineering employing a finite input/output semantic model (FIOSM).

47. The method of aspect 46 wherein said employing a finite input/output semantic model comprises designing a software programming language having decidable and complete dataflow wherein any and all software procedures created in the programming language can be represented by an FIOSM.

48. The method of aspect 46 wherein said employing a finite input/output semantic model comprises modifying an existing software programming language wherein any and all software procedures created in the programming language can be represented by an FIOSM.

49. The method of aspect 48 wherein the existing software language comprises one of C, C+, C++, Java, Basic, Pascal, and Fortran.

50. The method of aspect 48, wherein said modifying an existing software programming language comprises removing all operators (i) having ambiguous semantics and (ii) being capable of invoking infinite code paths.

51. The method of aspect 48, wherein said modifying an existing software programming language comprises removing all operators capable of invoking infinite code paths.

52. The method of aspect 50 wherein the existing software language comprises one of C, C+, C++, Java, Basic, Pascal, and Fortran.

53. The method of aspect 51 wherein the existing software language comprises one of C, C+, C++, Java, Basic, Pascal, and Fortran.

54. The method of aspect 50 further comprising replacing the removed operators with one or more alternative operators incapable of invoking infinite loops.

55. The method of aspect 51 further comprising replacing the removed operators with one or more alternative operators incapable of invoking infinite loops.

56. The method of aspect 52 further comprising replacing the removed operators with one or more alternative operators incapable of invoking infinite loops.

57. The method of aspect 53 further comprising replacing the removed operators with one or more alternative operators incapable of invoking infinite loops.

58. The method of aspect 50 further comprising replacing the removed operators with one or more alternative operators having unambiguous semantics.

59. The method of aspect 51 further comprising replacing the removed operators with one or more alternative operators having unambiguous semantics.

60. The method of aspect 52 further comprising replacing the removed operators with one or more alternative operators having unambiguous semantics.

61. The method of aspect 53 further comprising replacing the removed operators with one or more alternative operators having unambiguous semantics.

62. The method of aspect 50 wherein a for loop operator is replaced with “sum” operator.

63. The method of aspect 51 wherein a for loop operator is replaced with “sum” operator.

64. The method of aspect 52 wherein a for loop operator is replaced with “sum” operator.

65. The method of aspect 53 wherein a for loop operator is replaced with “sum” operator.

66. The method of aspect 48, wherein said modifying an existing software programming language comprises redefining one or more data types.

67. The method of aspect 48, wherein said modifying an existing software programming language comprises replacing one or more data types.

68. The method of aspect 49, wherein said modifying an existing software programming language comprises redefining one or more data types.

69. The method of aspect 49, wherein said modifying an existing software programming language comprises replacing one or more data types.

70. The method of aspect 50, wherein said modifying an existing software programming language comprises redefining one or more data types.

71. The method of aspect 50, wherein said modifying an existing software programming language comprises replacing one or more data types.

72. The method of aspect 51, wherein said modifying an existing software programming language comprises redefining one or more data types.

73. The method of aspect 51, wherein said modifying an existing software programming language comprises replacing one or more data types.

74. The method of aspect 52, wherein said modifying an existing software programming language comprises redefining one or more data types.

75. The method of aspect 52, wherein said modifying an existing software programming language comprises replacing one or more data types.

76. The method of aspect 53, wherein said modifying an existing software programming language comprises redefining one or more data types.

77. The method of aspect 53, wherein said modifying an existing software programming language comprises replacing one or more data types.

78. The method of aspect 54, wherein said modifying an existing software programming language comprises redefining one or more data types.

79. The method of aspect 54, wherein said modifying an existing software programming language comprises replacing one or more data types.

80. The method of aspect 55, wherein said modifying an existing software programming language comprises redefining one or more data types.

81. The method of aspect 55, wherein said modifying an existing software programming language comprises replacing one or more data types.

82. The method of aspect 56, wherein said modifying an existing software programming language comprises redefining one or more data types.

83. The method of aspect 56, wherein said modifying an existing software programming language comprises replacing one or more data types.

84. The method of aspect 57, wherein said modifying an existing software programming language comprises redefining one or more data types.

85. The method of aspect 57, wherein said modifying an existing software programming language comprises replacing one or more data types.

86. The method of aspect 58, wherein said modifying an existing software programming language comprises redefining one or more data types.

87. The method of aspect 58, wherein said modifying an existing software programming language comprises replacing one or more data types.

88. The method of aspect 59, wherein said modifying an existing software programming language comprises redefining one or more data types.

89. The method of aspect 59, wherein said modifying an existing software programming language comprises replacing one or more data types.

90. The method of aspect 60, wherein said modifying an existing software programming language comprises redefining one or more data types.

91. The method of aspect 60, wherein said modifying an existing software programming language comprises replacing one or more data types.

92. The method of aspect 61, wherein said modifying an existing software programming language comprises redefining one or more data types.

93. The method of aspect 61, wherein said modifying an existing software programming language comprises replacing one or more data types.

94. The method of aspect 47 wherein said designing a software programming language having decidable and complete dataflow comprises: (i) defining operators; and (ii) defining data types.

95. The method of aspect 94 further comprising: verifying the decidable and complete data flow.

96. The method of aspect 94 wherein defining operators includes only specifying operators whose semantics are not ambiguous or cannot invoke infinite code paths.

97. The method of aspect 95 wherein defining operators includes only specifying operators whose semantics are not ambiguous or cannot invoke infinite code paths.

98. The method of aspect 94 wherein the data types comprise enumerable and non-enumerable data types.

99. The method of aspect 94 wherein all data elements of the non-enumerated data types are represented as sets.

100. The method of aspect 99 wherein all data elements consisting of infinite sets are expressed with a finite lexical notation.

101. The method of aspect 99 wherein numeric data types are non-enumerated data types and numeric data elements of the numeric data types are expressed using equalities and/or inequalities.

102. The method of aspect 95 wherein the data types comprise enumerable and non-enumerable data types.

103. The method of aspect 95 wherein all data elements of the non-enumerated data types are represented as sets.

104. The method of aspect 103 wherein all data elements consisting of infinite sets are expressed with a finite lexical notation.

105. The method of aspect 103 wherein numeric data types are non-enumerated data types and numeric data elements of the numeric data types are expressed using equalities and/or inequalities.

106. The method of aspect 96 wherein the data types comprise enumerable and non-enumerable data types.

107. The method of aspect 96 wherein all data elements of the non-enumerated data types are represented as sets.

108. The method of aspect 107 wherein all data elements consisting of infinite sets are expressed with a finite lexical notation.

109. The method of aspect 107 wherein numeric data types are non-enumerated data types and numeric data elements of the numeric data types are expressed using equalities and/or inequalities.

110. The method of aspect 97 wherein the data types comprise enumerable and non-enumerable data types.

111. The method of aspect 97 wherein all data elements of the non-enumerated data types are represented as sets.

112. The method of aspect 111 wherein all data elements consisting of infinite sets are expressed with a finite lexical notation.

113. The method of aspect 111 wherein numeric data types are non-enumerated data types and numeric data elements of the numeric data types are expressed using equalities and/or inequalities.

114. The method of aspect 95 wherein said verifying decidable and complete data flow comprises verifying both a code path quality and a data flow quality of the language.

115. The method of aspect 114 wherein said verifying a code path quality comprises demonstrating all possible code paths within the language can be expressed in a finite tree model.

116. The method of aspect 115, wherein the tree model comprises a directed acyclic graph.

117. The method of aspect 115, wherein said demonstrating all possible code paths within the language comprises generating a tree model using a tableau algorithm.

118. The method of aspect 115, wherein said demonstrating all possible code paths within the language comprises generating a tree model using a model search algorithm.

119. The method of aspect 114, wherein verifying the data flow quality further comprises identifying a set of one or more complete and correct algorithms that can determine the value of any data element in the set of all programs written in the language.

120. The method of aspect 119 wherein said identifying a set of one or more complete and correct algorithms comprises demonstrating a valid algorithm for each data type associated with the language.

121. The method of aspect 120, wherein said demonstrating a valid algorithm for each data type comprises utilizing automated algebraic analysis.

122. The method of aspect 120, wherein said demonstrating a valid algorithm for each data type comprises utilizing approximation.

123. The method of aspect 95, further comprising: repeating said designing the language after said verifying the decidable and complete data flow if decidable and complete data flow is unverifiable.

124. The method of aspect 52, wherein the operations of designing and verifying are repeated iteratively until decidable and complete data flow is verified.

125. The method of aspect 46 wherein said employing a finite input/output semantic model comprises generating a software procedure and a corresponding FIOSM for the software procedure.

126. The method of aspect 46 wherein said employing a finite input/output semantic model comprises generating a software routine and a corresponding FIOSM for the software routine.

127. The method of aspect 46 wherein said employing a finite input/output semantic model comprises generating a software program and a corresponding FIOSM for the software program.

128. The method of aspect 46 wherein said employing a finite input/output semantic model comprises generating a software module and a corresponding FIOSM for the software module.

129. The method of aspect 46 wherein said employing a finite input/output semantic model comprises generating a software enterprise system and a corresponding FIOSM for the software enterprise system.

130. A method for generating a finite input/output semantic model comprising:
receiving a source program;
parsing the source program into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the source program,
   identifying a set of output data elements in the source program, and for each set of data elements, creating an input-output pattern expression;
   producing a valid data expression for each set of input data elements; and
   producing a valid data expression for each set of output data elements.

131. The method of aspect 130 wherein the source program is written in a finite input output semantic model compliant programming language.

132. The method of aspect 130 wherein the source program is written in programming language having unambiguous semantics and decidable and complete data flow.

133. The method of aspect 130 wherein the source program is written in programming language having unambiguous semantics and decidable and complete data flow.

134. The method of aspect 130 wherein the source program is written in programming language having unambiguous semantics and decidable and complete data flow.

135. The method of aspect 130 wherein the source program is written in programming language wherein each operator of a set consisting of all operators in the language has unambiguous semantics and is incapable of an invoking infinite code path.

136. The method of aspect 130 wherein the source program is written in programming language wherein each operator of a set consisting of all operators in the language is incapable of an invoking infinite code path.

137. The method of aspect 130 wherein the abstract data structure comprises a parse tree.

138. The method of aspect 130 wherein the abstract data structure comprises a tree model.

139. The method of aspect 130 wherein the abstract data structure comprises a directed acyclic graph structure.

140. The method of aspect 137 wherein said generating a set of code paths based on the abstract data structure comprises walking the parse tree.

141. The method of aspect 137 wherein said generating a set of code paths based on the abstract data structure comprises using a suitable algorithm to walk the parse tree.

142. The method of aspect 141 wherein the suitable algorithm is a model-splitting type algorithm.

143. The method of aspect 142 wherein the model-splitting type algorithm is a member of the Tableau family of algorithms.

144. The method of aspect 141 wherein the suitable algorithm is a book-marking type algorithm.

145. The method of aspect 141 wherein the suitable algorithm is a model search algorithm.

146. The method of aspect 130 wherein each data element model of the set of logically consistent data element models represents one input-output pattern of the source program.

147. The method of aspect 130, wherein converting the set of code paths into a set of logically consistent data element models includes discarding logically inconsistent data element models from the set of code paths.

148. The method of aspect 130, wherein converting the set of code paths into a set of logically consistent data element models includes (i) walking the set of code paths, (ii) generating the set of data element models, and (iii) testing each data element model of the set for data-element consistency.

149. A method comprising:
providing a known programming language; and
   modifying the language wherein any program written in the language is finite input output semantic model compliant.

150. The method of aspect 149 wherein the known programming language comprises one of: C, C+, C++, Java, Basic, Pascal, and Fortran.

151. The method of aspect 149, wherein said modifying language comprises removing all operators (i) having ambiguous semantics and (ii) being capable of invoking infinite code paths.

152. The method of aspect 150, wherein said modifying language comprises removing all operators (i) having ambiguous semantics and (ii) being capable of invoking infinite code paths.

153. The method of aspect 149, wherein said modifying an existing software programming language comprises removing all operators capable of invoking infinite code paths.

154. The method of aspect 150, wherein said modifying an existing software programming language comprises removing all operators capable of invoking infinite code paths.

155. The method of aspect 151 further comprising replacing the removed operators with one or more alternative operators incapable of invoking infinite loops.

156. The method of aspect 152 further comprising replacing the removed operators with one or more alternative operators incapable of invoking infinite loops.

157. The method of aspect 153 further comprising replacing the removed operators with one or more alternative operators incapable of invoking infinite loops.

158. The method of aspect 154 further comprising replacing the removed operators with one or more alternative operators incapable of invoking infinite loops.

159. The method of aspect 151 further comprising replacing the removed operators with one or more alternative operators having unambiguous semantics.

160. The method of aspect 152 further comprising replacing the removed operators with one or more alternative operators having unambiguous semantics.

161. The method of aspect 153 further comprising replacing the removed operators with one or more alternative operators having unambiguous semantics.

162. The method of aspect 154 further comprising replacing the removed operators with one or more alternative operators having unambiguous semantics.

163. The method of aspect 151 wherein a for loop operator is replaced with “sum” operator.

164. The method of aspect 152 wherein a for loop operator is replaced with “sum” operator.

165. The method of aspect 153 wherein a for loop operator is replaced with “sum” operator.

166. The method of aspect 154 wherein a for loop operator is replaced with “sum” operator.

167. The method of aspect 155 wherein a for loop operator is replaced with “sum” operator.

168. The method of aspect 156 wherein a for loop operator is replaced with “sum” operator.

169. The method of aspect 157 wherein a for loop operator is replaced with “sum” operator.

170. The method of aspect 158 wherein a for loop operator is replaced with “sum” operator.

171. The method of aspect 159 wherein a for loop operator is replaced with “sum” operator.

172. The method of aspect 160 wherein a for loop operator is replaced with “sum” operator.

173. The method of aspect 161 wherein a for loop operator is replaced with “sum” operator.

174. The method of aspect 162 wherein a for loop operator is replaced with “sum” operator.

175. The method of aspect 149, wherein said modifying the language comprises redefining one or more data types.

176. The method of aspect 149, wherein said modifying the language comprises replacing one or more data types.

177. The method of aspect 150, wherein said modifying the language comprises redefining one or more data types.

178. The method of aspect 150, wherein said modifying the language comprises replacing one or more data types.

179. The method of aspect 151, wherein said modifying the language comprises redefining one or more data types.

180. The method of aspect 151, wherein said modifying the language comprises replacing one or more data types.

181. The method of aspect 152, wherein said modifying the language comprises redefining one or more data types.

182. The method of aspect 152, wherein said modifying the language comprises replacing one or more data types.

183. The method of aspect 153, wherein said modifying the language comprises redefining one or more data types.

184. The method of aspect 153, wherein said modifying the language comprises replacing one or more data types.

185. The method of aspect 154, wherein said modifying the language comprises redefining one or more data types.

186. The method of aspect 154, wherein said modifying the language comprises replacing one or more data types.

187. The method of aspect 155, wherein said modifying the language comprises redefining one or more data types.

188. The method of aspect 155, wherein said modifying the language comprises replacing one or more data types.

189. The method of aspect 156, wherein said modifying the language comprises redefining one or more data types.

190. The method of aspect 156, wherein said modifying the language comprises replacing one or more data types.

191. The method of aspect 157, wherein said modifying the language comprises redefining one or more data types.

192. The method of aspect 157, wherein said modifying the language comprises replacing one or more data types.

193. The method of aspect 158, wherein said modifying the language comprises redefining one or more data types.

194. The method of aspect 158, wherein said modifying the language comprises replacing one or more data types.

195. The method of aspect 159, wherein said modifying the language comprises redefining one or more data types.

196. The method of aspect 159, wherein said modifying the language comprises replacing one or more data types.

197. The method of aspect 160, wherein said modifying the language comprises redefining one or more data types.

198. The method of aspect 160, wherein said modifying the language comprises replacing one or more data types.

199. The method of aspect 161, wherein said modifying the language comprises redefining one or more data types.

200. The method of aspect 161, wherein said modifying the language comprises replacing one or more data types.

201. The method of aspect 162, wherein said modifying the language comprises redefining one or more data types.

202. The method of aspect 162, wherein said modifying the language comprises replacing one or more data types.

203. The method of aspect 163, wherein said modifying the language comprises redefining one or more data types.

204. The method of aspect 163, wherein said modifying the language comprises replacing one or more data types.

205. The method of aspect 164, wherein said modifying the language comprises redefining one or more data types.

206. The method of aspect 164, wherein said modifying the language comprises replacing one or more data types.

207. The method of aspect 165, wherein said modifying the language comprises redefining one or more data types.

208. The method of aspect 165, wherein said modifying the language comprises replacing one or more data types.

209. The method of aspect 166, wherein said modifying the language comprises redefining one or more data types.

210. The method of aspect 166, wherein said modifying the language comprises replacing one or more data types.

211. The method of aspect 167, wherein said modifying the language comprises redefining one or more data types.

212. The method of aspect 167, wherein said modifying the language comprises replacing one or more data types.

213. The method of aspect 168, wherein said modifying the language comprises redefining one or more data types.

214. The method of aspect 168, wherein said modifying the language comprises replacing one or more data types.

215. The method of aspect 169, wherein said modifying the language comprises redefining one or more data types.

216. The method of aspect 169, wherein said modifying the language comprises replacing one or more data types.

217. The method of aspect 170, wherein said modifying the language comprises redefining one or more data types.

218. The method of aspect 170, wherein said modifying the language comprises replacing one or more data types.

219. The method of aspect 171, wherein said modifying the language comprises redefining one or more data types.

220. The method of aspect 171, wherein said modifying the language comprises replacing one or more data types.

221. The method of aspect 172, wherein said modifying the language comprises redefining one or more data types.

222. The method of aspect 172, wherein said modifying the language comprises replacing one or more data types.

223. The method of aspect 173, wherein said modifying the language comprises redefining one or more data types.

224. The method of aspect 173, wherein said modifying the language comprises replacing one or more data types.

225. The method of aspect 174, wherein said modifying the language comprises redefining one or more data types.

226. The method of aspect 174, wherein said modifying the language comprises replacing one or more data types.

227. The method of aspect 149 further comprising verifying that all programs created in the language have decidable and complete data flow.

228. A method comprising:
providing a known programming language; and
   modifying the language wherein the modified language satisfies both a finite code path property and a data flow property.

229. The method of aspect 228, further comprising verifying compliance with the finite code path property.

230. The method of aspect 228, further comprising verifying compliance with the data flow property.

231. The method of aspect 229, further comprising verifying compliance with the data flow property.

232. The method of aspect 228 wherein said modifying the language includes redefining one or more data types.

233. The method of aspect 229 wherein said modifying the language includes redefining one or more data types.

234. The method of aspect 230 wherein said modifying the language includes redefining one or more data types.

235. The method of aspect 231 wherein said modifying the language includes redefining one or more data types.

236. The method of aspect 228 wherein said modifying the language includes replacing one or more operators having ambiguous semantics with replacement operators having unambiguous semantics.

237. The method of aspect 229 wherein said modifying the language includes replacing one or more operators having ambiguous semantics with replacement operators having unambiguous semantics.

238. The method of aspect 230 wherein said modifying the language includes replacing one or more operators having ambiguous semantics with replacement operators having unambiguous semantics.

239. The method of aspect 231 wherein said modifying the language includes replacing one or more operators having ambiguous semantics with replacement operators having unambiguous semantics.

240. The method of aspect 232 wherein said modifying the language includes replacing one or more operators having ambiguous semantics with replacement operators having unambiguous semantics.

241. The method of aspect 233 wherein said modifying the language includes replacing one or more operators having ambiguous semantics with replacement operators having unambiguous semantics.

242. The method of aspect 234 wherein said modifying the language includes replacing one or more operators having ambiguous semantics with replacement operators having unambiguous semantics.

243. The method of aspect 235 wherein said modifying the language includes replacing one or more operators having ambiguous semantics with replacement operators having unambiguous semantics.

244. The method of aspect 232 wherein the redefined data types comprise enumerable and non-enumerable data types.

245. The method of aspect 233 wherein the redefined data types comprise enumerable and non-enumerable data types.

246. The method of aspect 234 wherein the redefined data types comprise enumerable and non-enumerable data types.

247. The method of aspect 235 wherein the redefined data types comprise enumerable and non-enumerable data types.

248. The method of aspect 232 wherein the redefined data types comprise enumerable and non-enumerable data types.

249. The method of aspect 244 wherein all data elements of the non-enumerated data types are represented as sets.

250. The method of aspect 245 wherein all data elements of the non-enumerated data types are represented as sets.

251. The method of aspect 246 wherein all data elements of the non-enumerated data types are represented as sets.

252. The method of aspect 247 wherein all data elements of the non-enumerated data types are represented as sets.

253. The method of aspect 248 wherein all data elements of the non-enumerated data types are represented as sets.

254. The method of aspect 249 wherein all data elements consisting of infinite sets are expressed with a finite lexical notation.

255. The method of aspect 250 wherein all data elements consisting of infinite sets are expressed with a finite lexical notation.

256. The method of aspect 251 wherein all data elements consisting of infinite sets are expressed with a finite lexical notation.

257. The method of aspect 252 wherein all data elements consisting of infinite sets are expressed with a finite lexical notation.

258. The method of aspect 253 wherein all data elements consisting of infinite sets are expressed with a finite lexical notation.

259. The method of aspect 249 wherein numeric data types are non-enumerated data types and numeric data elements of the numeric data types are expressed using equalities and/or inequalities.

260. The method of aspect 250 wherein numeric data types are non-enumerated data types and numeric data elements of the numeric data types are expressed using equalities and/or inequalities.

261. The method of aspect 251 wherein numeric data types are non-enumerated data types and numeric data elements of the numeric data types are expressed using equalities and/or inequalities.

262. The method of aspect 252 wherein numeric data types are non-enumerated data types and numeric data elements of the numeric data types are expressed using equalities and/or inequalities.

263. The method of aspect 253 wherein numeric data types are non-enumerated data types and numeric data elements of the numeric data types are expressed using equalities and/or inequalities.

264. The method of aspect 229 wherein said verifying compliance with the finite code path property comprises demonstrating all possible code paths within the language can be expressed in a finite tree model.

265. The method of aspect 264, wherein the tree model comprises a directed acyclic graph.

266. The method of aspect 265 wherein said demonstrating all possible code paths within the language comprises generating a tree model using a tableau algorithm.

267. The method of aspect 264 wherein said demonstrating all possible code paths within the language comprises generating a tree model using a tableau algorithm.

268. The method of aspect 264 wherein said demonstrating all possible code paths within the language comprises generating a tree model using a model search algorithm.

269. The method of aspect 230 wherein said further comprising verifying compliance with the finite code path property comprises demonstrating all possible code paths within the language can be expressed in a finite tree model.

270. The method of aspect 269, wherein the tree model comprises a directed acyclic graph.

271. The method of aspect 270 wherein said demonstrating all possible code paths within the language comprises generating a tree model using a tableau algorithm.

272. The method of aspect 269 wherein said demonstrating all possible code paths within the language comprises generating a tree model using a tableau algorithm.

273. The method of aspect 269 wherein said demonstrating all possible code paths within the language comprises generating a tree model using a model search algorithm.

274. The method of aspect 231 wherein said further comprising verifying compliance with the finite code path property comprises demonstrating all possible code paths within the language can be expressed in a finite tree model.

275. The method of aspect 274, wherein the tree model comprises a directed acyclic graph.

276. The method of aspect 275 wherein said demonstrating all possible code paths within the language comprises generating a tree model using a tableau algorithm.

277. The method of aspect 274 wherein said demonstrating all possible code paths within the language comprises generating a tree model using a tableau algorithm.

278. The method of aspect 274 wherein said demonstrating all possible code paths within the language comprises generating a tree model using a model search algorithm.

279. The method of aspect 230, wherein said verifying compliance with the data flow property comprises identifying a set of one or more complete and correct algorithms that can determine the value of any data element in the set of all programs written in the language.

280. The method of aspect 279 wherein said identifying a set of one or more complete and correct algorithms comprises demonstrating a valid algorithm for each data type associated with the language.

281. The method of aspect 280, wherein said demonstrating a valid algorithm for each data type comprises utilizing automated algebraic analysis.

282. The method of aspect 280, wherein said demonstrating a valid algorithm for each data type comprises utilizing approximation.

283. The method of aspect 234, wherein said verifying compliance with the data flow property comprises identifying a set of one or more complete and correct algorithms that can determine the value of any data element in the set of all programs written in the language.

284. The method of aspect 283 wherein said identifying a set of one or more complete and correct algorithms comprises demonstrating a valid algorithm for each data type associated with the language.

285. The method of aspect 284, wherein said demonstrating a valid algorithm for each data type comprises utilizing automated algebraic analysis.

286. The method of aspect 284, wherein said demonstrating a valid algorithm for each data type comprises utilizing approximation.

287. The method of aspect 238, wherein said verifying compliance with the data flow property comprises identifying a set of one or more complete and correct algorithms that can determine the value of any data element in the set of all programs written in the language.

288. The method of aspect 287 wherein said identifying a set of one or more complete and correct algorithms comprises demonstrating a valid algorithm for each data type associated with the language.

289. The method of aspect 288, wherein said demonstrating a valid algorithm for each data type comprises utilizing automated algebraic analysis.

290. The method of aspect 288, wherein said demonstrating a valid algorithm for each data type comprises utilizing approximation.

291. The method of aspect 229, further comprising: repeating modifying the language after said verifying compliance with the finite code path property if compliance with the finite code path property is unverifiable.

292. The method of aspect 291, wherein the operations of modifying and verifying are repeated iteratively until the finite code path property is verified.

293. The method of aspect 231, further comprising: repeating modifying the language after said verifying compliance with the finite code path property if compliance with the finite code path property is unverifiable.

294. The method of aspect 293, wherein the operations of modifying and verifying are repeated iteratively until the finite code path property is verified.

295. The method of aspect 233, further comprising: repeating modifying the language after said verifying compliance with the finite code path property if compliance with the finite code path property is unverifiable.

296. The method of aspect 295, wherein the operations of modifying and verifying are repeated iteratively until the finite code path property is verified.

297. The method of aspect 235, further comprising: repeating modifying the language after said verifying compliance with the finite code path property if compliance with the finite code path property is unverifiable.

298. The method of aspect 297, wherein the operations of modifying and verifying are repeated iteratively until the finite code path property is verified.

299. The method of aspect 237, further comprising: repeating modifying the language after said verifying compliance with the finite code path property if compliance with the finite code path property is unverifiable.

300. The method of aspect 299, wherein the operations of modifying and verifying are repeated iteratively until the finite code path property is verified.

301. The method of aspect 241, further comprising: repeating modifying the language after said verifying compliance with the finite code path property if compliance with the finite code path property is unverifiable.

302. The method of aspect 301, wherein the operations of modifying and verifying are repeated iteratively until the finite code path property is verified.

303. The method of aspect 243, further comprising: repeating modifying the language after said verifying compliance with the finite code path property if compliance with the finite code path property is unverifiable.

304. The method of aspect 303, wherein the operations of modifying and verifying are repeated iteratively until the finite code path property is verified.

305. The method of aspect 245, further comprising: repeating modifying the language after said verifying compliance with the finite code path property if compliance with the finite code path property is unverifiable.

306. The method of aspect 305, wherein the operations of modifying and verifying are repeated iteratively until the finite code path property is verified.

307. The method of aspect 247, further comprising: repeating modifying the language after said verifying compliance with the finite code path property if compliance with the finite code path property is unverifiable.

308. The method of aspect 307, wherein the operations of modifying and verifying are repeated iteratively until the finite code path property is verified.

309. The method of aspect 250, further comprising: repeating modifying the language after said verifying compliance with the finite code path property if compliance with the finite code path property is unverifiable.

310. The method of aspect 309, wherein the operations of modifying and verifying are repeated iteratively until the finite code path property is verified.

311. The method of aspect 252, further comprising: repeating modifying the language after said verifying compliance with the finite code path property if compliance with the finite code path property is unverifiable.

312. The method of aspect 311, wherein the operations of modifying and verifying are repeated iteratively until the finite code path property is verified.

313. The method of aspect 255, further comprising: repeating modifying the language after said verifying compliance with the finite code path property if compliance with the finite code path property is unverifiable.

314. The method of aspect 313, wherein the operations of modifying and verifying are repeated iteratively until the finite code path property is verified.

315. The method of aspect 257, further comprising: repeating modifying the language after said verifying compliance with the finite code path property if compliance with the finite code path property is unverifiable.

316. The method of aspect 315, wherein the operations of modifying and verifying are repeated iteratively until the finite code path property is verified.

317. The method of aspect 260, further comprising: repeating modifying the language after said verifying compliance with the finite code path property if compliance with the finite code path property is unverifiable.

318. The method of aspect 317, wherein the operations of modifying and verifying are repeated iteratively until the finite code path property is verified.

319. The method of aspect 262, further comprising: repeating modifying the language after said verifying compliance with the finite code path property if compliance with the finite code path property is unverifiable.

320. The method of aspect 319, wherein the operations of modifying and verifying are repeated iteratively until the finite code path property is verified.

321. The method of aspect 264, further comprising: repeating modifying the language after said verifying compliance with the finite code path property if compliance with the finite code path property is unverifiable.

322. The method of aspect 321, wherein the operations of modifying and verifying are repeated iteratively until the finite code path property is verified.

323. The method of aspect 265, further comprising: repeating modifying the language after said verifying compliance with the finite code path property if compliance with the finite code path property is unverifiable.

324. The method of aspect 323, wherein the operations of modifying and verifying are repeated iteratively until the finite code path property is verified.

325. The method of aspect 266, further comprising: repeating modifying the language after said verifying compliance with the finite code path property if compliance with the finite code path property is unverifiable.

326. The method of aspect 325, wherein the operations of modifying and verifying are repeated iteratively until the finite code path property is verified.

327. The method of aspect 267, further comprising: repeating modifying the language after said verifying compliance with the finite code path property if compliance with the finite code path property is unverifiable.

328. The method of aspect 327, wherein the operations of modifying and verifying are repeated iteratively until the finite code path property is verified.

329. The method of aspect 268, further comprising: repeating modifying the language after said verifying compliance with the finite code path property if compliance with the finite code path property is unverifiable.

330. The method of aspect 329, wherein the operations of modifying and verifying are repeated iteratively until the finite code path property is verified.

331. The method of aspect 274, further comprising: repeating modifying the language after said verifying compliance with the finite code path property if compliance with the finite code path property is unverifiable.

332. The method of aspect 331, wherein the operations of modifying and verifying are repeated iteratively until the finite code path property is verified.

333. The method of aspect 277, further comprising: repeating modifying the language after said verifying compliance with the finite code path property if compliance with the finite code path property is unverifiable.

334. The method of aspect 333, wherein the operations of modifying and verifying are repeated iteratively until the finite code path property is verified.

335. The method of aspect 278, further comprising: repeating modifying the language after said verifying compliance with the finite code path property if compliance with the finite code path property is unverifiable.

336. The method of aspect 335, wherein the operations of modifying and verifying are repeated iteratively until the finite code path property is verified.

337. A method of creating a computer language wherein a set of all programs created in the language have a decidable and complete data flow comprising:
designing the language including defining operators and defining data types; and
verifying the decidable and complete data flow.

338. The method of aspect 337 wherein defining operators includes only specifying operators whose semantics are not ambiguous or cannot invoke infinite code paths.

339. The method of aspect 337 wherein the data types comprise enumerable and non-enumerable data types.

340. The method of aspect 339 wherein all data elements of the non-enumerated data types are represented as sets.

341. The method of aspect 340 wherein all data elements consisting of infinite sets are expressed with a finite lexical notation.

342. The method of aspect 340 wherein numeric data types are non-enumerated data types and numeric data elements of the numeric data types are expressed using equalities and/or inequalities.

343. The method of aspect 337 wherein verifying decidable and complete data flow comprises verifying both a code path quality and a data flow quality of the language.

344. The method of aspect 343 wherein said verifying a code path quality comprises demonstrating all possible code paths within the language can be expressed in a finite tree model.

345. The method of aspect 344, wherein the tree model comprises a directed acyclic graph.

346. The method of aspect 344 wherein said demonstrating all possible code paths within the language comprises generating a tree model using a tableau algorithm.

347. The method of aspect 343, wherein verifying the data flow quality further comprises identifying a set of one or more complete and correct algorithms that can determine the value of any data element in the set of all programs written in the language.

348. The method of aspect 347 wherein said identifying a set of one or more complete and correct algorithms comprises demonstrating a valid algorithm for each data type associated with the language.

349. The method of aspect 348, wherein said demonstrating a valid algorithm for each data type comprises utilizing automated algebraic analysis.

350. The method of aspect 348, wherein said demonstrating a valid algorithm for each data type comprises utilizing approximation.

351. The method of aspect 337, further comprising: repeating said designing the language after said verifying the decidable and complete data flow if decidable and complete data flow is unverifiable.

352. The method of aspect 351, wherein the operations of designing and verifying are repeated iteratively until decidable and complete data flow is verified.

353. The method of aspect 337 wherein defining control flow operators includes only specifying control flow operators whose semantics are not ambiguous or result in infinite code paths.

354. A method of creating a computer language wherein a finite input output model (FIOSM) can be generated for all programs created in the language, the method comprising:
designing the language including defining operators and defining data types; and
verifying an FIOSM can be generated for all programs created in the language by verifying all programs have decidable and complete data flow.

355. The method of aspect 354 wherein defining operators includes only specifying operators whose semantics are not ambiguous or cannot invoke infinite code paths.

356. The method of aspect 354 wherein the data types comprise enumerable and non-enumerable data types.

357. The method of aspect 356 wherein all data elements of the non-enumerated data types are represented as sets.

358. The method of aspect 357 wherein all data elements consisting of infinite sets are expressed with a finite lexical notation.

359. The method of aspect 357 wherein numeric data types are non-enumerated data types and numeric data elements of the numeric data types are expressed using equalities and/or inequalities.

360. The method of aspect 354 wherein verifying decidable and complete data flow comprises verifying both a code path quality and a data flow quality of the language.

361. The method of aspect 360 wherein said verifying a code path quality comprises demonstrating all possible code paths within the language can be expressed in a finite tree model.

362. The method of aspect 361, wherein the tree model comprises a directed acyclic graph.

363. The method of aspect 361, wherein said demonstrating all possible code paths within the language comprises generating a tree model using a tableau algorithm.

364. The method of aspect 360, wherein verifying the data flow quality further comprises identifying a set of one or more complete and correct algorithms that can determine the value of any data element in the set of all programs written in the language.

365. The method of aspect 364, wherein said identifying a set of one or more complete and correct algorithms comprises demonstrating a valid algorithm for each data type associated with the language.

366. The method of aspect 365, wherein said demonstrating a valid algorithm for each data type comprises utilizing automated algebraic analysis.

367. The method of aspect 365, wherein said demonstrating a valid algorithm for each data type comprises utilizing approximation.

368. The method of aspect 354, further comprising: repeating said designing the language after said verifying the decidable and complete data flow if decidable and complete data flow is unverifiable.

369. The method of aspect 366, wherein the operations of designing and verifying are repeated iteratively until decidable and complete data flow is verified.

370. The method of aspect 354 wherein defining operators includes only specifying operators whose semantics are not ambiguous or result in infinite code paths.

371. A method of creating the computer language wherein each operator of a set consisting of all operators in the language has unambiguous semantics and is incapable of an invoking infinite code path, the method comprising:
designing the language including defining the set of all operators and defining a set of data types; and
verifying that each operator of the set of operators is incapable of invoking an infinite loop.

372. The method of aspect 371 wherein the set of data types includes enumerable and non-enumerable data types.

373. The method of aspect 372 wherein all data elements of the non-enumerated data types are represented as sets.

374. The method of aspect 373 wherein all data elements consisting of infinite sets are expressed with a finite lexical notation.

375. The method of aspect 373 wherein numeric data types are non-enumerated data types and numeric data elements of the numeric data types are expressed using equalities and/or inequalities.

376. The method of aspect 371 wherein said verifying that each operator of the set of operators is incapable of invoking an infinite loop comprises verifying both a code path quality and a data flow quality of the language.

377. The method of aspect 376 wherein said verifying a code path quality comprises demonstrating all possible code paths within the language can be expressed in a finite tree model.

378. The method of aspect 377, wherein the tree model comprises a directed acyclic graph.

379. The method of aspect 377 wherein said demonstrating all possible code paths within the language comprises generating a tree model using a tableau algorithm.

380. The method of aspect 376, wherein verifying the data flow quality further comprises identifying a set of one or more complete and correct algorithms that can determine the value of any data element in the set of all programs written in the language.

381. The method of aspect 379 wherein said identifying a set of one or more complete and correct algorithms comprises demonstrating a valid algorithm for each data type associated with the language.

382. The method of aspect 381, wherein said demonstrating a valid algorithm for each data type comprises utilizing automated algebraic analysis.

383. The method of aspect 381, wherein said demonstrating a valid algorithm for each data type comprises utilizing approximation.

384. The method of aspect 371, further comprising: repeating said designing the language after said that each operator of the set of operators is incapable of invoking an infinite loop is unverifiable.

385. The method of aspect 384, wherein the operations of designing and verifying are repeated iteratively until decidable and complete data flow is verified.

386. A method of creating the computer language wherein each operator of a set consisting of all operators in the language is incapable of invoking an infinite code path, the method comprising:
designing the language including defining the set of all operators and defining a set of data types; and
verifying that each operator of the set of operators is incapable of invoking an infinite loop.

387. The method of aspect 386 wherein the set of data types includes enumerable and non-enumerable data types.

388. The method of aspect 387 wherein all data elements of the non-enumerated data types are represented as sets.

389. The method of aspect 388 wherein all data elements consisting of infinite sets are expressed with a finite lexical notation.

390. The method of aspect 388 wherein numeric data types are non-enumerated data types and numeric data elements of the numeric data types are expressed using equalities and/or inequalities.

391. The method of aspect 386 wherein said verifying that each operator of the set of operators is incapable of invoking an infinite loop comprises verifying both a code path quality and a data flow quality of the language.

392. The method of aspect 391 wherein said verifying a code path quality comprises demonstrating all possible code paths within the language can be expressed in a finite tree model.

393. The method of aspect 392, wherein the tree model comprises a directed acyclic graph.

394. The method of aspect 392 wherein said demonstrating all possible code paths within the language comprises generating a tree model using a tableau algorithm.

395. The method of aspect 391, wherein verifying the data flow quality further comprises identifying a set of one or more complete and correct algorithms that can determine the value of any data element in the set of all programs written in the language.

396. The method of aspect 395 wherein said identifying a set of one or more complete and correct algorithms comprises demonstrating a valid algorithm for each data type associated with the language.

397. The method of aspect 396, wherein said demonstrating a valid algorithm for each data type comprises utilizing automated algebraic analysis.

398. The method of aspect 396, wherein said demonstrating a valid algorithm for each data type comprises utilizing approximation.

399. The method of aspect 386, further comprising: repeating said designing the language after said that each operator of the set of operators is incapable of invoking an infinite loop is unverifiable.

400. The method of aspect 399, wherein the operations of designing and verifying are repeated iteratively until decidable and complete data flow is verified.

401. A method comprising:
creating a finite input output semantic model (FIOSM) compliant programming language;
generating a software program in the FIOSM compliant language; and
generating a FIOSM for the program.

402. The method of aspect 401 wherein said creating a finite input output semantic model (FIOSM) compliant programming language further comprises:
providing a known programming language; and
modifying the known program language into the FIOSM compliant language wherein any program written in the language is FIOSM compliant.

403. The method of aspect 402 wherein the known programming language comprises one of: C, C+, C++, Java, Basic, Pascal, and Fortran.

404. The method of aspect 402, wherein said modifying language comprises removing all operators (i) having ambiguous semantics and (ii) being capable of invoking infinite code paths.

405. The method of aspect 403, wherein said modifying language comprises removing all operators (i) having ambiguous semantics and (ii) being capable of invoking infinite code paths.

406. The method of aspect 402, wherein said modifying an existing software programming language comprises removing all operators capable of invoking infinite code paths.

407. The method of aspect 403, wherein said modifying an existing software programming language comprises removing all operators capable of invoking infinite code paths.

408. The method of aspect 404 further comprising replacing the removed operators with one or more alternative operators incapable of invoking infinite loops.

409. The method of aspect 405 further comprising replacing the removed operators with one or more alternative operators incapable of invoking infinite loops.

410. The method of aspect 406 further comprising replacing the removed operators with one or more alternative operators incapable of invoking infinite loops.

411. The method of aspect 407 further comprising replacing the removed operators with one or more alternative operators incapable of invoking infinite loops.

412. The method of aspect 404 further comprising replacing the removed operators with one or more alternative operators having unambiguous semantics.

413. The method of aspect 405 further comprising replacing the removed operators with one or more alternative operators having unambiguous semantics.

414. The method of aspect 406 further comprising replacing the removed operators with one or more alternative operators having unambiguous semantics.

415. The method of aspect 407 further comprising replacing the removed operators with one or more alternative operators having unambiguous semantics.

416. The method of aspect 404 wherein a for loop operator is replaced with “sum” operator.

417. The method of aspect 405 wherein a for loop operator is replaced with “sum” operator.

418. The method of aspect 406 wherein a for loop operator is replaced with “sum” operator.

419. The method of aspect 407 wherein a for loop operator is replaced with “sum” operator.

420. The method of aspect 408 wherein a for loop operator is replaced with “sum” operator.

421. The method of aspect 409 wherein a for loop operator is replaced with “sum” operator.

422. The method of aspect 410 wherein a for loop operator is replaced with “sum” operator.

423. The method of aspect 411 wherein a for loop operator is replaced with “sum” operator.

424. The method of aspect 412 wherein a for loop operator is replaced with “sum” operator.

425. The method of aspect 413 wherein a for loop operator is replaced with “sum” operator.

426. The method of aspect 414 wherein a for loop operator is replaced with “sum” operator.

427. The method of aspect 414 wherein a for loop operator is replaced with “sum” operator.

428. The method of aspect 402, wherein said modifying the language comprises redefining one or more data types.

429. The method of aspect 402, wherein said modifying the language comprises replacing one or more data types.

430. The method of aspect 403, wherein said modifying the language comprises redefining one or more data types.

431. The method of aspect 403, wherein said modifying the language comprises replacing one or more data types.

432. The method of aspect 404, wherein said modifying the language comprises redefining one or more data types.

433. The method of aspect 404, wherein said modifying the language comprises replacing one or more data types.

434. The method of aspect 405, wherein said modifying the language comprises redefining one or more data types.

435. The method of aspect 405, wherein said modifying the language comprises replacing one or more data types.

436. The method of aspect 406, wherein said modifying the language comprises redefining one or more data types.

437. The method of aspect 406, wherein said modifying the language comprises replacing one or more data types.

438. The method of aspect 407, wherein said modifying the language comprises redefining one or more data types.

439. The method of aspect 407, wherein said modifying the language comprises replacing one or more data types.

440. The method of aspect 408, wherein said modifying the language comprises redefining one or more data types.

441. The method of aspect 408, wherein said modifying the language comprises replacing one or more data types.

442. The method of aspect 409, wherein said modifying the language comprises redefining one or more data types.

443. The method of aspect 409, wherein said modifying the language comprises replacing one or more data types.

444. The method of aspect 410, wherein said modifying the language comprises redefining one or more data types.

445. The method of aspect 410, wherein said modifying the language comprises replacing one or more data types.

446. The method of aspect 411, wherein said modifying the language comprises redefining one or more data types.

447. The method of aspect 411, wherein said modifying the language comprises replacing one or more data types.

448. The method of aspect 412, wherein said modifying the language comprises redefining one or more data types.

449. The method of aspect 412, wherein said modifying the language comprises replacing one or more data types.

450. The method of aspect 413, wherein said modifying the language comprises redefining one or more data types.

451. The method of aspect 413, wherein said modifying the language comprises replacing one or more data types.

452. The method of aspect 414, wherein said modifying the language comprises redefining one or more data types.

453. The method of aspect 414, wherein said modifying the language comprises replacing one or more data types.

454. The method of aspect 415, wherein said modifying the language comprises redefining one or more data types.

455. The method of aspect 415, wherein said modifying the language comprises replacing one or more data types.

456. The method of aspect 416, wherein said modifying the language comprises redefining one or more data types.

457. The method of aspect 416, wherein said modifying the language comprises replacing one or more data types.

458. The method of aspect 417, wherein said modifying the language comprises redefining one or more data types.

459. The method of aspect 417, wherein said modifying the language comprises replacing one or more data types.

460. The method of aspect 418, wherein said modifying the language comprises redefining one or more data types.

461. The method of aspect 418, wherein said modifying the language comprises replacing one or more data types.

462. The method of aspect 419, wherein said modifying the language comprises redefining one or more data types.

463. The method of aspect 419, wherein said modifying the language comprises replacing one or more data types.

464. The method of aspect 420, wherein said modifying the language comprises redefining one or more data types.

465. The method of aspect 420, wherein said modifying the language comprises replacing one or more data types.

466. The method of aspect 421, wherein said modifying the language comprises redefining one or more data types.

467. The method of aspect 421, wherein said modifying the language comprises replacing one or more data types.

468. The method of aspect 422, wherein said modifying the language comprises redefining one or more data types.

469. The method of aspect 422, wherein said modifying the language comprises replacing one or more data types.

470. The method of aspect 423, wherein said modifying the language comprises redefining one or more data types.

471. The method of aspect 423, wherein said modifying the language comprises replacing one or more data types.

472. The method of aspect 423, wherein said modifying the language comprises redefining one or more data types.

473. The method of aspect 424, wherein said modifying the language comprises replacing one or more data types.

474. The method of aspect 424, wherein said modifying the language comprises redefining one or more data types.

475. The method of aspect 425, wherein said modifying the language comprises replacing one or more data types.

476. The method of aspect 425, wherein said modifying the language comprises redefining one or more data types.

477. The method of aspect 426, wherein said modifying the language comprises replacing one or more data types.

478. The method of aspect 426, wherein said modifying the language comprises redefining one or more data types.

479. The method of aspect 427, wherein said modifying the language comprises replacing one or more data types.

480. The method of aspect 402 further comprising verifying that all programs created in the language have decidable and complete data flow.

481. The method of aspect 401 wherein said creating a finite input output semantic model (FIOSM) compliant programming language further comprises:
designing the language including defining operators and defining data types; and
verifying an FIOSM can be generated for all programs created in the language by verifying all programs have decidable and complete data flow.

482. The method of aspect 481 wherein defining operators includes only specifying operators whose semantics are not ambiguous or cannot invoke infinite code paths.

483. The method of aspect 481 wherein the data types comprise enumerable and non-enumerable data types.

484. The method of aspect 483 wherein all data elements of the non-enumerated data types are represented as sets.

485. The method of aspect 484 wherein all data elements consisting of infinite sets are expressed with a finite lexical notation.

486. The method of aspect 484 wherein numeric data types are non-enumerated data types and numeric data elements of the numeric data types are expressed using equalities and/or inequalities.

487. The method of aspect 481 wherein verifying decidable and complete data flow comprises verifying both a code path quality and a data flow quality of the language.

488. The method of aspect 487 wherein said verifying a code path quality comprises demonstrating all possible code paths within the language can be expressed in a finite tree model.

489. The method of aspect 488, wherein the tree model comprises a directed acyclic graph.

490. The method of aspect 488, wherein said demonstrating all possible code paths within the language comprises generating a tree model using a tableau algorithm.

491. The method of aspect 487, wherein verifying the data flow quality further comprises identifying a set of one or more complete and correct algorithms that can determine the value of any data element in the set of all programs written in the language.

492. The method of aspect 491, wherein said identifying a set of one or more complete and correct algorithms comprises demonstrating a valid algorithm for each data type associated with the language.

493. The method of aspect 492, wherein said demonstrating a valid algorithm for each data type comprises utilizing automated algebraic analysis.

494. The method of aspect 492, wherein said demonstrating a valid algorithm for each data type comprises utilizing approximation.

495. The method of aspect 481, further comprising: repeating said designing the language after said verifying the decidable and complete data flow if decidable and complete data flow is unverifiable.

496. The method of aspect 493, wherein the operations of designing and verifying are repeated iteratively until decidable and complete data flow is verified.

497. The method of aspect 481 wherein defining operators includes only specifying operators whose semantics are not ambiguous or result in infinite code paths.

498. The method of aspect 401 wherein said creating a finite input output semantic model (FIOSM) compliant programming language further comprises:
defining the set of all operators in the language
defining a set of all data types in the language; and
verifying that each operator of the set of operators is incapable of invoking an infinite loop.

499. The method of aspect 498 wherein the set of data types includes enumerable and non-enumerable data types.

500. The method of aspect 499 wherein all data elements of the non-enumerated data types are represented as sets.

501. The method of aspect 500 wherein all data elements consisting of infinite sets are expressed with a finite lexical notation.

502. The method of aspect 500 wherein numeric data types are non-enumerated data types and numeric data elements of the numeric data types are expressed using equalities and/or inequalities.

503. The method of aspect 498 wherein said verifying that each operator of the set of operators is incapable of invoking an infinite loop comprises verifying both a code path quality and a data flow quality of the language.

504. The method of aspect 503 wherein said verifying a code path quality comprises demonstrating all possible code paths within the language can be expressed in a finite tree model.

505. The method of aspect 504, wherein the tree model comprises a directed acyclic graph.

506. The method of aspect 504 wherein said demonstrating all possible code paths within the language comprises generating a tree model using a tableau algorithm.

507. The method of aspect 503, wherein verifying the data flow quality further comprises identifying a set of one or more complete and correct algorithms that can determine the value of any data element in the set of all programs written in the language.

508. The method of aspect 507 wherein said identifying a set of one or more complete and correct algorithms comprises demonstrating a valid algorithm for each data type associated with the language.

509. The method of aspect 508, wherein said demonstrating a valid algorithm for each data type comprises utilizing automated algebraic analysis.

510. The method of aspect 508, wherein said demonstrating a valid algorithm for each data type comprises utilizing approximation.

511. The method of aspect 498, further comprising: repeating said creating a finite input output semantic model (FIOSM) compliant programming language is unverifiable.

512. The method of aspect 511, wherein the operations of creating and verifying are repeated iteratively until decidable and complete data flow is verified.

513. The method of aspect 401 wherein said generating a FIOSM for the program further comprises:
generating a parse tree;
generating a code path set based on the parse tree;
generating a path data model set using the code path set; and
generating a finite input/output semantic model (FIOSM) from the path data model set.

514. The method of aspect 513, wherein the generation of a finite input/output semantic model dictates that the software has a completely decidable data flow.

515. The method of aspect 513 wherein said generating a parse tree comprises parsing the source code of the program.

516. The method of aspect 513 wherein the parse tree comprises a directed acyclic graph structure (DAG).

517. The method of aspect 513, wherein said generating a code path set based on the parse tree comprises utilizing a suitable algorithm to walk the parse tree.

518. The method of aspect 513, wherein the code path set comprises condition free code path trees.

519. The method of aspect 517, wherein the suitable algorithm comprises a tableau algorithm.

520. The method of aspect 517, wherein the suitable algorithm comprises a book-marking algorithm.

521. The method of aspect 513, wherein the path data model set comprises a plurality of logically consistent data element models.

522. The method of aspect 521, wherein said generating a path data model set using the code path set includes discarding any logically inconsistent data element models.

523. The method of aspect 513, wherein said generating a path data model set using the code path set comprises for each code path set element: (i) walking the code path parse tree of the code path set element; (ii) recording assignments and constraints for the code path set element.

524. The method of aspect 513, wherein said generating a path data model set using the code path set comprises converting the code path set into a set of logically consistent data model elements.

525. The method of aspect 513, wherein said generating a finite input/output semantic model (FIOSM) from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

526. The method of aspect 525, wherein said formatting a FIOSM from the path data model set further comprises: eliminating intermediate data elements.

527. The method of aspect 401 wherein the program does not include operators having ambiguous semantics or control flow operators capable of invoking infinite code paths.

528. The method of aspect 401 wherein the software program includes a plurality of operators wherein no combination of operators of the plurality of operators are capable of invoking an infinite code path in the computer program.

529. The method of aspect 401 wherein the software program comprises at least 1,000 lines.

530. The method of aspect 401 wherein the software program comprises at least 10,000 lines.

531. The method of aspect 401 wherein the software program comprises at least 100,000 lines.

532. The method of aspect 401 wherein the software program comprises at least 1,000,000 lines.

533. The method of aspect 401, wherein the FIOSM consists of all possible inputs to the program and all possible outputs the software program can generate based on all possible inputs.

534. The method of aspect 401 wherein said generating a FIOSM for the program further comprises:
parsing the source code of the program to generate a parse tree;
generating a code path set using the parse tree;
generating a path data model set using the code path set; and
formatting a FIOSM from the path data model set.

535. The method of aspect 534, wherein the parse tree comprises a directed acyclic graph structure (DAG).

536. The method of aspect 534, wherein the parse tree comprises a directed acyclic graph structure (DAG).

537. The method of aspect 534, wherein the parse tree comprises a tree model.

538. The method of aspect 534, wherein said generating code path sets using the parse tree comprises utilizing a suitable algorithm to walk the parse tree.

539. The method of aspect 539 wherein the suitable algorithm comprises a tableau algorithm.

540. The method of aspect 539 wherein the suitable algorithm comprises a model search algorithm.

541. The method of aspect 534 wherein the path data model set comprises a plurality of logically consistent data element models.

542. The method of aspect 539 wherein said generating a path data model set using the code path set includes discarding any logically inconsistent data element models.

543. The method of aspect 534 wherein said generating a path data model set using the code path sets comprises for each code path set element: (i) walking the code path parse tree of the code path set element; (ii) recording assignments and constraints for the code path set element.

544. The method of aspect 534 wherein said formatting a FIOSM from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

545. The method of aspect 544, wherein said formatting a FIOSM from the path data model set further comprises: eliminating intermediate data elements.

546. The method of aspect 401 wherein said generating a FIOSM for the program further comprises:
parsing the program into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the program,
   identifying a set of output data elements in the program, and for each set of data elements, creating an input-output pattern expression;
   producing a valid data expression for each set of input data elements; and
   producing a valid data expression for each set of output data elements.

547. The method of aspect 546 wherein the abstract data structure comprises a parse tree.

548. The method of aspect 546 wherein the abstract data structure comprises a tree model.

549. The method of aspect 546 wherein the abstract data structure comprises a directed acyclic graph structure.

550. The method of aspect 547 wherein said generating a set of code paths based on the abstract data structure comprises walking the parse tree.

551. The method of aspect 547 wherein said generating a set of code paths based on the abstract data structure comprises using a suitable algorithm to walk the parse tree.

552. The method of aspect 551 wherein the suitable algorithm is a model-splitting type algorithm.

553. The method of aspect 552 wherein the model-splitting type algorithm is a member of the Tableau family of algorithms.

554. The method of aspect 551 wherein the suitable algorithm is a book-marking type algorithm.

555. The method of aspect 551 wherein the suitable algorithm is a model search algorithm.

556. The method of aspect 546 wherein each data element model of the set of logically consistent data element models represents one input-output pattern of the source program.

557. The method of aspect 546, wherein converting the set of code paths into a set of logically consistent data element models includes discarding logically inconsistent data element models from the set of code paths.

558. The method of aspect 546, wherein converting the set of code paths into a set of logically consistent data element models includes (i) walking the set of code paths, (ii) generating the set of data element models, and (iii) testing each data element model of the set for data-element consistency.

559. A method comprising:
creating a finite input output semantic model (FIOSM) compliant programming language;
generating a software procedure in the FIOSM compliant language; and
generating a FIOSM for the procedure.

560. The method of aspect 559 wherein said generating a FIOSM for the procedure further comprises:
generating a parse tree;
generating a code path set based on the parse tree;
generating a path data model set using the code path set; and
generating a finite input/output semantic model (FIOSM) from the path data model set.

561. The method of aspect 560, wherein the generation of a finite input/output semantic model dictates that the software has a completely decidable data flow.

562. The method of aspect 560 wherein said generating a parse tree comprises parsing the source code of the procedure.

563. The method of aspect 560 wherein the parse tree comprises a directed acyclic graph structure (DAG).

564. The method of aspect 560, wherein said generating a code path set based on the parse tree comprises utilizing a suitable algorithm to walk the parse tree.

565. The method of aspect 560, wherein the code path set comprises condition free code path trees.

566. The method of aspect 564, wherein the suitable algorithm comprises a tableau algorithm.

567. The method of aspect 564, wherein the suitable algorithm comprises a book-marking algorithm.

568. The method of aspect 560, wherein the path data model set comprises a plurality of logically consistent data element models.

569. The method of aspect 568, wherein said generating a path data model set using the code path set includes discarding any logically inconsistent data element models.

570. The method of aspect 560, wherein said generating a path data model set using the code path set comprises for each code path set element: (i) walking the code path parse tree of the code path set element; (ii) recording assignments and constraints for the code path set element.

571. The method of aspect 560, wherein said generating a path data model set using the code path set comprises converting the code path set into a set of logically consistent data model elements.

572. The method of aspect 560, wherein said generating a finite input/output semantic model (FIOSM) from the path data model set comprises: (i) identifying a set of input data elements in the procedure; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

573. The method of aspect 572, wherein said formatting a FIOSM from the path data model set further comprises: eliminating intermediate data elements.

574. The method of aspect 559 wherein the procedure does not include operators having ambiguous semantics or control flow operators capable of invoking infinite code paths.

575. The method of aspect 559 wherein the software procedure includes a plurality of operators wherein no combination of operators of the plurality of operators are capable of invoking an infinite code path in the procedure.

576. The method of aspect 559 wherein the software procedure comprises at least 1,000 lines.

577. The method of aspect 559 wherein the software procedure comprises at least 10,000 lines.

578. The method of aspect 559 wherein the software procedure comprises at least 100,000 lines.

579. The method of aspect 559 wherein the software procedure comprises at least 1,000,000 lines.

580. The method of aspect 559, wherein the FIOSM consists of all possible inputs to the procedure and all possible outputs the software procedure can generate based on all possible inputs.

581. The method of aspect 559 wherein said generating a FIOSM for the procedure further comprises:
parsing the source code of the procedure to generate a parse tree;
generating a code path set using the parse tree;
generating a path data model set using the code path set; and
formatting a FIOSM from the path data model set.

582. The method of aspect 581, wherein the parse tree comprises a directed acyclic graph structure (DAG).

583. The method of aspect 581, wherein the parse tree comprises a directed acyclic graph structure (DAG).

584. The method of aspect 581, wherein the parse tree comprises a tree model

585. The method of aspect 581, wherein said generating code path sets using the parse tree comprises utilizing a suitable algorithm to walk the parse tree.

586. The method of aspect 585 wherein the suitable algorithm comprises a tableau algorithm.

587. The method of aspect 585 wherein the suitable algorithm comprises a model search algorithm.

588. The method of aspect 571 wherein the path data model set comprises a plurality of logically consistent data element models.

589. The method of aspect 586 wherein said generating a path data model set using the code path set includes discarding any logically inconsistent data element models.

590. The method of aspect 581 wherein said generating a path data model set using the code path sets comprises for each code path set element: (i) walking the code path parse tree of the code path set element; (ii) recording assignments and constraints for the code path set element.

591. The method of aspect 581 wherein said formatting a FIOSM from the path data model set comprises: (i) identifying a set of input data elements in the procedure; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

592. The method of aspect 591, wherein said formatting a FIOSM from the path data model set further comprises: eliminating intermediate data elements.

593. The method of aspect 599 wherein said generating a FIOSM for the procedure further comprises:
parsing the procedure into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the procedure,
   identifying a set of output data elements in the procedure, and for each set of data elements, creating an input-output pattern expression;
   producing a valid data expression for each set of input data elements; and producing a valid data expression for each set of output data elements.

594. The method of aspect 593 wherein the abstract data structure comprises a parse tree.

595. The method of aspect 593 wherein the abstract data structure comprises a tree model.

596. The method of aspect 593 wherein the abstract data structure comprises a directed acyclic graph structure.

597. The method of aspect 594 wherein said generating a set of code paths based on the abstract data structure comprises walking the parse tree.

598. The method of aspect 594 wherein said generating a set of code paths based on the abstract data structure comprises using a suitable algorithm to walk the parse tree.

599. The method of aspect 598 wherein the suitable algorithm is a model-splitting type algorithm.

600. The method of aspect 599 wherein the model-splitting type algorithm is a member of the Tableau family of algorithms.

601. The method of aspect 598 wherein the suitable algorithm is a book-marking type algorithm.

602. The method of aspect 598 wherein the suitable algorithm is a model search algorithm.

603. The method of aspect 593 wherein each data element model of the set of logically consistent data element models represents one input-output pattern of the source procedure.

604. The method of aspect 593, wherein converting the set of code paths into a set of logically consistent data element models includes discarding logically inconsistent data element models from the set of code paths.

605. The method of aspect 593, wherein converting the set of code paths into a set of logically consistent data element models includes (i) walking the set of code paths, (ii) generating the set of data element models, and (iii) testing each data element model of the set for data-element consistency.

606. A method comprising:
creating a finite input output semantic model (FIOSM) compliant programming language;
generating a software routine in the FIOSM compliant language; and
generating a FIOSM for the routine.

607. The method of aspect 606 wherein said generating a FIOSM for the routine further comprises:
generating a parse tree;
generating a code path set based on the parse tree;
generating a path data model set using the code path set; and
generating a finite input/output semantic model (FIOSM) from the path data model set.

608. The method of aspect 607, wherein the generation of a finite input/output semantic model dictates that the software has a completely decidable data flow.

609. The method of aspect 607 wherein said generating a parse tree comprises parsing the source code of the routine.

610. The method of aspect 607 wherein the parse tree comprises a directed acyclic graph structure (DAG).

611. The method of aspect 607, wherein said generating a code path set based on the parse tree comprises utilizing a suitable algorithm to walk the parse tree.

612. The method of aspect 607, wherein the code path set comprises condition free code path trees.

613. The method of aspect 611, wherein the suitable algorithm comprises a tableau algorithm.

614. The method of aspect 611, wherein the suitable algorithm comprises a book-marking algorithm.

615. The method of aspect 607, wherein the path data model set comprises a plurality of logically consistent data element models.

616. The method of aspect 615, wherein said generating a path data model set using the code path set includes discarding any logically inconsistent data element models.

617. The method of aspect 607, wherein said generating a path data model set using the code path set comprises for each code path set element: (i) walking the code path parse tree of the code path set element; (ii) recording assignments and constraints for the code path set element.

618. The method of aspect 607, wherein said generating a path data model set using the code path set comprises converting the code path set into a set of logically consistent data model elements.

619. The method of aspect 607, wherein said generating a finite input/output semantic model (FIOSM) from the path data model set comprises: (i) identifying a set of input data elements in the routine; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

620. The method of aspect 619, wherein said formatting a FIOSM from the path data model set further comprises: eliminating intermediate data elements.

621. The method of aspect 606 wherein the routine does not include operators having ambiguous semantics or control flow operators capable of invoking infinite code paths.

622. The method of aspect 606 wherein the software routine includes a plurality of operators wherein no combination of operators of the plurality of operators are capable of invoking an infinite code path in the routine.

623. The method of aspect 606 wherein the software routine comprises at least 1,000 lines.

624. The method of aspect 606 wherein the software routine comprises at least 10,000 lines.

625. The method of aspect 606 wherein the software routine comprises at least 100,000 lines.

626. The method of aspect 606 wherein the software routine comprises at least 1,000,000 lines.

627. The method of aspect 606, wherein the FIOSM consists of all possible inputs to the routine and all possible outputs the software routine can generate based on all possible inputs.

628. The method of aspect 606 wherein said generating a FIOSM for the routine further comprises:
parsing the source code of the routine to generate a parse tree;
generating a code path set using the parse tree;
generating a path data model set using the code path set; and
formatting a FIOSM from the path data model set.

629. The method of aspect 628, wherein the parse tree comprises a directed acyclic graph structure (DAG).

630. The method of aspect 628, wherein the parse tree comprises a directed acyclic graph structure (DAG).

631. The method of aspect 628, wherein the parse tree comprises a tree model

632. The method of aspect 628, wherein said generating code path sets using the parse tree comprises utilizing a suitable algorithm to walk the parse tree.

633. The method of aspect 633 wherein the suitable algorithm comprises a tableau algorithm.

634. The method of aspect 633 wherein the suitable algorithm comprises a model search algorithm.

635. The method of aspect 628 wherein the path data model set comprises a plurality of logically consistent data element models.

636. The method of aspect 633 wherein said generating a path data model set using the code path set includes discarding any logically inconsistent data element models.

637. The method of aspect 628 wherein said generating a path data model set using the code path sets comprises for each code path set element: (i) walking the code path parse tree of the code path set element; (ii) recording assignments and constraints for the code path set element.

638. The method of aspect 628 wherein said formatting a FIOSM from the path data model set comprises: (i) identifying a set of input data elements in the routine; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

639. The method of aspect 638, wherein said formatting a FIOSM from the path data model set further comprises: eliminating intermediate data elements.

640. The method of aspect 606 wherein said generating a FIOSM for the routine further comprises:
parsing the routine into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the routine,
   identifying a set of output data elements in the routine, and for each set of data elements, creating an input-output pattern expression;
   producing a valid data expression for each set of input data elements; and
   producing a valid data expression for each set of output data elements.

641. The method of aspect 640 wherein the abstract data structure comprises a parse tree.

642. The method of aspect 640 wherein the abstract data structure comprises a tree model.

643. The method of aspect 640 wherein the abstract data structure comprises a directed acyclic graph structure.

644. The method of aspect 641 wherein said generating a set of code paths based on the abstract data structure comprises walking the parse tree.

645. The method of aspect 641 wherein said generating a set of code paths based on the abstract data structure comprises using a suitable algorithm to walk the parse tree.

646. The method of aspect 645 wherein the suitable algorithm is a model-splitting type algorithm.

647. The method of aspect 646 wherein the model-splitting type algorithm is a member of the Tableau family of algorithms.

648. The method of aspect 645 wherein the suitable algorithm is a book-marking type algorithm.

649. The method of aspect 645 wherein the suitable algorithm is a model search algorithm.

650. The method of aspect 640 wherein each data element model of the set of logically consistent data element models represents one input-output pattern of the source routine.

651. The method of aspect 640, wherein converting the set of code paths into a set of logically consistent data element models includes discarding logically inconsistent data element models from the set of code paths.

652. The method of aspect 640, wherein converting the set of code paths into a set of logically consistent data element models includes (i) walking the set of code paths, (ii) generating the set of data element models, and (iii) testing each data element model of the set for data-element consistency.

653. A method comprising:
creating a finite input output semantic model (FIOSM) compliant programming language;
generating a software enterprise system in the FIOSM compliant language; and
generating a FIOSM for the enterprise system.

654. The method of aspect 653 wherein said generating a FIOSM for the enterprise system further comprises:
generating a parse tree;
generating a code path set based on the parse tree;
generating a path data model set using the code path set; and
generating a finite input/output semantic model (FIOSM) from the path data model set.

655. The method of aspect 654, wherein the generation of a finite input/output semantic model dictates that the software has a completely decidable data flow.

656. The method of aspect 654 wherein said generating a parse tree comprises parsing the source code of the enterprise system.

657. The method of aspect 654 wherein the parse tree comprises a directed acyclic graph structure (DAG).

658. The method of aspect 654, wherein said generating a code path set based on the parse tree comprises utilizing a suitable algorithm to walk the parse tree.

659. The method of aspect 654, wherein the code path set comprises condition free code path trees.

660. The method of aspect 658, wherein the suitable algorithm comprises a tableau algorithm.

661. The method of aspect 658, wherein the suitable algorithm comprises a book-marking algorithm.

662. The method of aspect 654, wherein the path data model set comprises a plurality of logically consistent data element models.

663. The method of aspect 562, wherein said generating a path data model set using the code path set includes discarding any logically inconsistent data element models.

664. The method of aspect 554, wherein said generating a path data model set using the code path set comprises for each code path set element: (i) walking the code path parse tree of the code path set element; (ii) recording assignments and constraints for the code path set element.

665. The method of aspect 554, wherein said generating a path data model set using the code path set comprises converting the code path set into a set of logically consistent data model elements.

666. The method of aspect 554, wherein said generating a finite input/output semantic model (FIOSM) from the path data model set comprises: (i) identifying a set of input data elements in the enterprise system; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

667. The method of aspect 566, wherein said formatting a FIOSM from the path data model set further comprises: eliminating intermediate data elements.

668. The method of aspect 653 wherein the enterprise system does not include operators having ambiguous semantics or control flow operators capable of invoking infinite code paths.

669. The method of aspect 653 wherein the software enterprise system includes a plurality of operators wherein no combination of operators of the plurality of operators are capable of invoking an infinite code path in the enterprise system.

670. The method of aspect 653 wherein the software enterprise system comprises at least 1,000 lines.

671. The method of aspect 653 wherein the software enterprise system comprises at least 10,000 lines.

672. The method of aspect 653 wherein the software enterprise system comprises at least 100,000 lines.

673. The method of aspect 653 wherein the software enterprise system comprises at least 1,000,000 lines.

674. The method of aspect 653, wherein the FIOSM consists of all possible inputs to the enterprise system and all possible outputs the software enterprise system can generate based on all possible inputs.

675. The method of aspect 653 wherein said generating a FIOSM for the enterprise system further comprises:
parsing the source code of the enterprise system to generate a parse tree;
generating a code path set using the parse tree;
generating a path data model set using the code path set; and
formatting a FIOSM from the path data model set.

676. The method of aspect 675, wherein the parse tree comprises a directed acyclic graph structure (DAG).

677. The method of aspect 675, wherein the parse tree comprises a directed acyclic graph structure (DAG).

678. The method of aspect 675, wherein the parse tree comprises a tree model

679. The method of aspect 675, wherein said generating code path sets using the parse tree comprises utilizing a suitable algorithm to walk the parse tree.

680. The method of aspect 680 wherein the suitable algorithm comprises a tableau algorithm.

681. The method of aspect 680 wherein the suitable algorithm comprises a model search algorithm.

682. The method of aspect 675 wherein the path data model set comprises a plurality of logically consistent data element models.

683. The method of aspect 680 wherein said generating a path data model set using the code path set includes discarding any logically inconsistent data element models.

684. The method of aspect 675 wherein said generating a path data model set using the code path sets comprises for each code path set element: (i) walking the code path parse tree of the code path set element; (ii) recording assignments and constraints for the code path set element.

685. The method of aspect 675 wherein said formatting a FIOSM from the path data model set comprises: (i) identifying a set of input data elements in the enterprise system; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

686. The method of aspect 685, wherein said formatting a FIOSM from the path data model set further comprises: eliminating intermediate data elements.

687. The method of aspect 653 wherein said generating a FIOSM for the enterprise system further comprises:
parsing the enterprise system into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the enterprise system,
   identifying a set of output data elements in the enterprise system, and for each set of data elements, creating an input-output pattern expression;
   producing a valid data expression for each set of input data elements; and
   producing a valid data expression for each set of output data elements.

688. The method of aspect 687 wherein the abstract data structure comprises a parse tree.

689. The method of aspect 687 wherein the abstract data structure comprises a tree model

690. The method of aspect 687 wherein the abstract data structure comprises a directed acyclic graph structure.

691. The method of aspect 688 wherein said generating a set of code paths based on the abstract data structure comprises walking the parse tree.

692. The method of aspect 688 wherein said generating a set of code paths based on the abstract data structure comprises using a suitable algorithm to walk the parse tree.

693. The method of aspect 692 wherein the suitable algorithm is a model-splitting type algorithm.

694. The method of aspect 693 wherein the model-splitting type algorithm is a member of the Tableau family of algorithms.

695. The method of aspect 692 wherein the suitable algorithm is a book-marking type algorithm.

696. The method of aspect 692 wherein the suitable algorithm is a model search algorithm.

697. The method of aspect 687 wherein each data element model of the set of logically consistent data element models represents one input-output pattern of the source enterprise system.

698. The method of aspect 687, wherein converting the set of code paths into a set of logically consistent data element models includes discarding logically inconsistent data element models from the set of code paths.

699. The method of aspect 687, wherein converting the set of code paths into a set of logically consistent data element models includes (i) walking the set of code paths, (ii) generating the set of data element models, and (iii) testing each data element model of the set for data-element consistency.

700. A method of creating an FIOSM compliant programming language comprising:
designing a programming language;
defining a finite input output semantic model; and
verifying code path and data flow qualities of the programming language.

701. The method of aspect 700, wherein said designing a programming language includes precluding control flow operators capable of causing ambiguous or infinite code paths in programs written in the language.

702. The method of aspect 700, wherein said designing a programming language includes converting an existing computer language by modifying existing control flow operators to prevent invocation of infinite looping.

703. The method of aspect 700, wherein said designing a programming language includes converting an existing computer language to eliminate control flow operators capable of causing ambiguous or infinite code paths in programs written in the language.

704. The method of aspect 700, wherein said designing a programming language includes specifying operators that cannot invoke looping.

705. The method of aspect 700, wherein the programming language does not include one or more of the following operators: “for”; “if-then-else”; “while-do”; “goto”; “procedure calls”; and any other operator that has equivalent functionality as the foregoing.

706. The method of aspect 700, wherein said defining a finite input output semantic model includes: generating all possible data constraint expressions; generating an input-output pattern of data expressions; and generating the finite input output model comprising all possible input-output data patterns.

707. The method of aspect 705, wherein said generating an input-output pattern of data expressions comprises generating a data expression for each data type.

708. The method of aspect 706 wherein each data type specified for use in the language has a data constraint expression associated with the data type, each data expression (i) being lexically finite and (ii) representing a defined set of values.

709. The method of aspect 705, wherein infinite sets are expressed with a finite lexical notation for applicable data constraint expressions.

710. The method of aspect 708, wherein the finite lexical notation includes equalities and inequalities.

711. The method of aspect 700 wherein said verifying code path and data flow qualities of the programming language includes demonstrating all codes paths written in the language result in a directed acyclic graph representation (DAG).

712. The method of aspect 710, wherein a tableau algorithm is utilized to generate the DAG.

713. The method of aspect 700 further comprising generating a finite input output semantic model for a software program written in the language.

714. The method of aspect 712 comprising:
parsing the source code of a program to generate a parse tree;
generating code path sets using the parse tree;
generating a path data model set using the code path sets; and
formatting a FIOSM from the path data model set.

715. A method comprising:
providing a software program having fully decidable data flow; and
representing the program in a parse tree.

716. The method of aspect 715, wherein the parse tree comprises a tree model.

717. The method of aspect 715, wherein the parse tree comprises a directed acyclic graph (DAG).

718. The method of aspect 715 wherein the software program is written in a finite input output model compliant programming language.

719. The method of aspect 715 further comprises walking the parse tree to generate code path sets utilizing a suitable algorithm.

720. The method aspect 719, wherein the suitable algorithm comprises a tableau algorithm.

721. The method of aspect 719, wherein the suitable algorithm comprises a tree model algorithm.

722. The method of aspect 715 further comprises generating code path sets using the parse tree.

723. The method of aspect 715 further comprises generating a path data model set using the code path sets.

724. The method of aspect 715 further comprises formatting a FIOSM from the path data model set.

725. A method comprising:
providing a software procedure having fully decidable data flow; and
representing the procedure in a parse tree.

726. The method of aspect 725, wherein the parse tree comprises a tree model.

727. The method of aspect 725, wherein the parse tree comprises a directed acyclic graph (DAG).

728. The method of aspect 725 wherein the software procedure is written in a finite input output model compliant programming language.

729. The method of aspect 725 further comprises walking the parse tree to generate code path sets utilizing a suitable algorithm.

730. The method aspect 729, wherein the suitable algorithm comprises a tableau algorithm.

731. The method of aspect 729, wherein the suitable algorithm comprises a tree model algorithm.

732. The method of aspect 725 further comprises generating code path sets using the parse tree.

733. The method of aspect 725 further comprises generating a path data model set using the code path sets.

734. The method of aspect 725 further comprises formatting a FIOSM from the path data model set.

735. A method comprising:
providing a software routine having fully decidable data flow; and
representing the routine in a parse tree.

736. The method of aspect 735, wherein the parse tree comprises a tree model.

737. The method of aspect 735, wherein the parse tree comprises a directed acyclic graph (DAG).

738. The method of aspect 735 wherein the software routine is written in a finite input output model compliant programming language.

739. The method of aspect 735 further comprises walking the parse tree to generate code path sets utilizing a suitable algorithm.

740. The method aspect 739, wherein the suitable algorithm comprises a tableau algorithm.

741. The method of aspect 739, wherein the suitable algorithm comprises a tree model algorithm.

742. The method of aspect 735 further comprises generating code path sets using the parse tree.

743. The method of aspect 735 further comprises generating a path data model set using the code path sets.

744. The method of aspect 735 further comprises formatting a FIOSM from the path data model set.

745. A method comprising:
providing a software module having fully decidable data flow; and
representing the module in a parse tree.

746. The method of aspect 745, wherein the parse tree comprises a tree model.

747. The method of aspect 745, wherein the parse tree comprises a directed acyclic graph (DAG).

748. The method of aspect 745 wherein the software module is written in a finite input output model compliant programming language.

749. The method of aspect 745 further comprises walking the parse tree to generate code path sets utilizing a suitable algorithm.

750. The method aspect 749, wherein the suitable algorithm comprises a tableau algorithm.

751. The method of aspect 749, wherein the suitable algorithm comprises a tree model algorithm.

752. The method of aspect 745 further comprises generating code path sets using the parse tree.

753. The method of aspect 745 further comprises generating a path data model set using the code path sets.

754. The method of aspect 745 further comprises formatting a FIOSM from the path data model set.

755. A method comprising:
providing a software enterprise system having fully decidable data flow; and
representing the enterprise system in a parse tree.

756. The method of aspect 755, wherein the parse tree comprises a tree model.

757. The method of aspect 755, wherein the parse tree comprises a directed acyclic graph (DAG).

758. The method of aspect 755 wherein the software enterprise system is written in a finite input output model compliant programming language.

759. The method of aspect 755 further comprises walking the parse tree to generate code path sets utilizing a suitable algorithm.

760. The method aspect 759, wherein the suitable algorithm comprises a tableau algorithm.

761. The method of aspect 759, wherein the suitable algorithm comprises a tree model algorithm.

762. The method of aspect 755 further comprises generating code path sets using the parse tree.

763. The method of aspect 755 further comprises generating a path data model set using the code path sets.

764. The method of aspect 755 further comprises formatting a FIOSM from the path data model set.

765. A method of developing software comprising:
generating a finite input/output semantic model for the software; and
using the model for ensuring quality of the software.

766. A method of automating software quality control utilizing a finite input/output semantic model.

767. A method of automating software quality control based on a finite input/output semantic model of the software.

768. A method for software quality control comprising:
a step for generating a parse tree;
a step for generating a code path set based on the parse tree;
a step for generating a path data model set using the code path set; and
a step for generating a finite input/output semantic model (FIOSM) from the path data model set.

769. The method of aspect 768, wherein the step for the generation of a finite input/output semantic model dictates that the software has a completely decidable data flow.

770. The method of aspect 768 wherein said step for generating a parse tree comprises parsing the source code of a software procedure.

771. The method of aspect 768 wherein said step for generating a parse tree comprises parsing the source code of a software program.

772. The method of aspect 768 wherein the parse tree comprises a directed acyclic graph structure (DAG).

773. The method of aspect 770, wherein the source code is written in a FIOSM compliant programming language.

774. The method of aspect 771, wherein the source code is written in a FIOSM compliant programming language.

775. The method of aspect 768, wherein said step for generating a code path set based on the parse tree comprises utilizing a suitable algorithm to walk the parse tree.

776. The method of aspect 768, wherein the code path set comprises condition free code path trees.

777. The method of aspect 775, wherein the suitable algorithm comprises a tableau algorithm.

778. The method of aspect 775, wherein the suitable algorithm comprises a book-marking algorithm.

779. The method of aspect 768, wherein the path data model set comprises a plurality of logically consistent data element models.

780. The method of aspect 779, wherein said step for generating a path data model set using the code path set includes discarding any logically inconsistent data element models.

781. The method of aspect 768, wherein said step for generating a path data model set using the code path set comprises for each code path set element: (i) a step for walking the code path parse tree of the code path set element; (ii) a step for recording assignments and constraints for the code path set element.

782. The method of aspect 768, wherein said step for generating a path data model set using the code path set comprises a step for converting the code path set into a set of logically consistent data model elements.

783. The method of aspect 768, wherein said step for generating a finite input/output semantic model (FIOSM) from the path data model set comprises: (i) a step for identifying a set of input data elements in the program; (ii) identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

784. The method of aspect 783, wherein said step for formatting a FIOSM from the path data model set further comprises: a step for eliminating intermediate data elements.

785. A method comprising:
a step for providing a software program written in a finite input-output semantic model (FIOSM) compliant language; and
a step for generating a FIOSM for the software program.

786. The method of aspect 785, wherein the FIOSM compliant language comprises a modified version of an existing language.

787. The method of aspect 785, wherein the existing language is one of C, C+, C++, Java, Basic, Pascal, and Fortran.

788. The method of aspect 785, further comprising a step for creating a FIOSM compliant language.

789. The method of aspect 785, further a step for comprising modifying an existing computer language to be a FIOSM compliant language.

790. The method of aspect 785, further comprising a step for modifying an existing non-FIOSM compliant computer language to be the FIOSM compliant language.

791. The method of aspect 785, wherein the FIOSM compliant language does not include operators having ambiguous semantics.

792. The method of aspect 785, wherein the FIOSM compliant language does not include operators capable of invoking infinite code paths.

793. The method of aspect 791, wherein the FIOSM compliant language does not include operators capable of invoking infinite code paths.

794. The method of aspect 785 wherein the software program does not include operators having ambiguous semantics or control flow operators capable of invoking infinite code paths.

795. The method of aspect 785 wherein the software program includes a plurality of operators wherein no combination of operators of the plurality of operators are capable of invoking an infinite code path in the computer program.

796. The method of aspect 785 wherein the software program comprises at least 1,000 lines.

797. The method of aspect 785 wherein the software program comprises at least 10,000 lines.

798. The method of aspect 785 wherein the software program comprises at least 100,000 lines.

799. The method of aspect 785 wherein the software program comprises at least 1,000,000 lines.

800. The method of aspect 785, wherein said generating a FIOSM further comprises:
a step for parsing the source code of the program to generate a parse tree;
a step for generating a code path set using the parse tree;
a step for generating a path data model set using the code path set; and
a step for formatting a FIOSM from the path data model set.

801. The method of aspect 785, wherein the FIOSM consists of all possible inputs to the software program and all possible outputs the software program can generate based on all possible inputs.

802. The method of aspect 800, wherein the parse tree comprises a directed acyclic graph structure (DAG).

803. The method of aspect 800, wherein the parse tree comprises a directed acyclic graph structure (DAG).

804. The method of aspect 800, wherein the parse tree comprises a tree model.

805. The method of aspect 800 wherein said step for generating code path sets using the parse tree comprises utilizing a suitable algorithm to walk the parse tree.

806. The method of aspect 805 wherein the suitable algorithm comprises a tableau algorithm.

807. The method of aspect 805 wherein the suitable algorithm comprises a model search algorithm.

808. The method of aspect 800 wherein the path data model set comprises a plurality of logically consistent data element models.

809. The method of aspect 805 wherein said generating a path data model set using the code path set includes discarding any logically inconsistent data element models.

810. The method of aspect 800 wherein said step for generating a path data model set using the code path sets comprises for each code path set element: (i) step for walking the code path parse tree of the code path set element; (ii) step for recording assignments and constraints for the code path set element.

811. The method of aspect 800 wherein said step for formatting a FIOSM from the path data model set comprises: (i) step for identifying a set of input data elements in the program; (ii) step for identifying a set of output data elements; (iii) for each member of the path data model set, step for creating a input-output pattern expression; (iv) for each input data element, step for generating an input data expression and adding it to an input set; and (v) for each output data element, step for generating an output data expression and adding it to an output set.

812. The method of aspect 811, wherein said step for formatting a FIOSM from the path data model set further comprises: a step for eliminating intermediate data elements.

813. A method of software engineering utilizing one or more steps for employing a finite input/output semantic model (FIOSM).

814. The method of aspect 813 wherein said step for employing a finite input/output semantic model comprises step for designing a software programming language having decidable and complete dataflow wherein any and all software procedures created in the programming language can be represented by an FIOSM.

815. The method of aspect 813 wherein said step for employing a finite input/output semantic model comprises step for modifying an existing software programming language wherein any and all software procedures created in the programming language can be represented by an FIOSM.

816. The method of aspect 815 wherein the existing software language comprises one of C, C+, C++, Java, Basic, Pascal, and Fortran.

817. The method of aspect 815, wherein said step for modifying an existing software programming language comprises a step for removing all operators (i) having ambiguous semantics and (ii) being capable of invoking infinite code paths.

818. The method of aspect 815, wherein said step for modifying an existing software programming language comprises a step for removing all operators capable of invoking infinite code paths.

819. The method of aspect 817 wherein the existing software language comprises one of C, C+, C++, Java, Basic, Pascal, and Fortran.

820. The method of aspect 818 wherein the existing software language comprises one of C, C+, C++, Java, Basic, Pascal, and Fortran.

821. The method of aspect 817 further comprising a step for replacing the removed operators with one or more alternative operators incapable of invoking infinite loops.

822. The method of aspect 818 further comprising a step for replacing the removed operators with one or more alternative operators incapable of invoking infinite loops.

823. The method of aspect 819 further comprising a step for replacing the removed operators with one or more alternative operators incapable of invoking infinite loops.

824. The method of aspect 820 further comprising replacing the removed operators with one or more alternative operators incapable of invoking infinite loops.

825. The method of aspect 817 further comprising a step for replacing the removed operators with one or more alternative operators having unambiguous semantics.

826. The method of aspect 818 further comprising a step for replacing the removed operators with one or more alternative operators having unambiguous semantics.

827. The method of aspect 819 further comprising a step for replacing the removed operators with one or more alternative operators having unambiguous semantics.

828. The method of aspect 820 further comprising a step for replacing the removed operators with one or more alternative operators having unambiguous semantics.

829. The method of aspect 817 wherein a for loop operator is replaced with “sum” operator.

830. The method of aspect 818 wherein a for loop operator is replaced with “sum” operator.

831. The method of aspect 819 wherein a for loop operator is replaced with “sum” operator.

832. The method of aspect 820 wherein a for loop operator is replaced with “sum” operator.

833. The method of aspect 815, wherein said step for modifying an existing software programming language comprises a step for redefining one or more data types.

834. The method of aspect 815, wherein said step for modifying an existing software programming language comprises a step for replacing one or more data types.

835. The method of aspect 816, wherein said step for modifying an existing software programming language comprises a step for redefining one or more data types.

836. The method of aspect 816, wherein said step for modifying an existing software programming language comprises a step for replacing one or more data types.

837. The method of aspect 817, wherein said step for modifying an existing software programming language comprises a step for redefining one or more data types.

838. The method of aspect 817, wherein said step for modifying an existing software programming language comprises a step for replacing one or more data types.

839. The method of aspect 818, wherein said step for modifying an existing software programming language comprises a step for redefining one or more data types.

840. The method of aspect 818, wherein said step for modifying an existing software programming language comprises a step for replacing one or more data types.

841. The method of aspect 819, wherein said step for modifying an existing software programming language comprises a step for redefining one or more data types.

842. The method of aspect 819, wherein said step for modifying an existing software programming language comprises a step for replacing one or more data types.

843. The method of aspect 820, wherein said step for modifying an existing software programming language comprises a step for redefining one or more data types.

844. The method of aspect 820, wherein said step for modifying an existing software programming language comprises a step for replacing one or more data types.

845. The method of aspect 821, wherein said step for modifying an existing software programming language comprises a step for redefining one or more data types.

846. The method of aspect 821, wherein said step for modifying an existing software programming language comprises a step for replacing one or more data types.

847. The method of aspect 822, wherein said step for modifying an existing software programming language comprises a step for redefining one or more data types.

848. The method of aspect 822, wherein said step for modifying an existing software programming language comprises a step for replacing one or more data types.

849. The method of aspect 823, wherein said step for modifying an existing software programming language comprises a step for redefining one or more data types.

850. The method of aspect 823, wherein said step for modifying an existing software programming language comprises a step for replacing one or more data types.

851. The method of aspect 824, wherein said step for modifying an existing software programming language comprises a step for redefining one or more data types.

852. The method of aspect 824, wherein said step for modifying an existing software programming language comprises a step for replacing one or more data types.

853. The method of aspect 825, wherein said step for modifying an existing software programming language comprises a step for redefining one or more data types.

854. The method of aspect 825, wherein said step for modifying an existing software programming language comprises a step for replacing one or more data types.

855. The method of aspect 826, wherein said step for modifying an existing software programming language comprises a step for redefining one or more data types.

856. The method of aspect 826, wherein said step for modifying an existing software programming language comprises a step for replacing one or more data types.

857. The method of aspect 827, wherein said step for modifying an existing software programming language comprises a step for redefining one or more data types.

858. The method of aspect 827, wherein said step for modifying an existing software programming language comprises a step for replacing one or more data types.

859. The method of aspect 828, wherein said step for modifying an existing software programming language comprises a step for redefining one or more data types.

860. The method of aspect 828, wherein said step for modifying an existing software programming language comprises a step for replacing one or more data types.

861. The method of aspect 814 wherein said designing a software programming language having decidable and complete dataflow comprises: (i) defining operators; and (ii) defining data types.

862. The method of aspect 861 further comprising a step for verifying the decidable and complete data flow.

863. The method of aspect 861 wherein the step for defining operators includes only specifying operators whose semantics are not ambiguous or cannot invoke infinite code paths.

864. The method of aspect 862 wherein the step for defining operators includes only specifying operators whose semantics are not ambiguous or cannot invoke infinite code paths.

865. The method of aspect 861 wherein the data types comprise enumerable and non-enumerable data types.

866. The method of aspect 861 wherein all data elements of the non-enumerated data types are represented as sets.

867. The method of aspect 866 wherein all data elements consisting of infinite sets are expressed with a finite lexical notation.

868. The method of aspect 866 wherein numeric data types are non-enumerated data types and numeric data elements of the numeric data types are expressed using equalities and/or inequalities.

869. The method of aspect 862 wherein the data types comprise enumerable and non-enumerable data types.

870. The method of aspect 862 wherein all data elements of the non-enumerated data types are represented as sets.

871. The method of aspect 870 wherein all data elements consisting of infinite sets are expressed with a finite lexical notation.

872. The method of aspect 870 wherein numeric data types are non-enumerated data types and numeric data elements of the numeric data types are expressed using equalities and/or inequalities.

873. The method of aspect 863 wherein the data types comprise enumerable and non-enumerable data types.

874. The method of aspect 863 wherein all data elements of the non-enumerated data types are represented as sets.

875. The method of aspect 874 wherein all data elements consisting of infinite sets are expressed with a finite lexical notation.

876. The method of aspect 874 wherein numeric data types are non-enumerated data types and numeric data elements of the numeric data types are expressed using equalities and/or inequalities.

877. The method of aspect 864 wherein the data types comprise enumerable and non-enumerable data types.

878. The method of aspect 864 wherein all data elements of the non-enumerated data types are represented as sets.

879. The method of aspect 878 wherein all data elements consisting of infinite sets are expressed with a finite lexical notation.

880. The method of aspect 878 wherein numeric data types are non-enumerated data types and numeric data elements of the numeric data types are expressed using equalities and/or inequalities.

881. The method of aspect 862 wherein said verifying decidable and complete data flow comprises verifying both a code path quality and a data flow quality of the language.

882. The method of aspect 881 wherein said verifying a code path quality comprises demonstrating all possible code paths within the language can be expressed in a finite tree model.

883. The method of aspect 882, wherein the tree model comprises a directed acyclic graph.

884. The method of aspect 882, wherein said step for demonstrating all possible code paths within the language comprises generating a tree model using a tableau algorithm.

885. The method of aspect 882, wherein said step for demonstrating all possible code paths within the language comprises a step for generating a tree model using a model search algorithm.

886. The method of aspect 881, wherein the step for verifying the data flow quality further comprises a step for identifying a set of one or more complete and correct algorithms that can determine the value of any data element in the set of all programs written in the language.

887. The method of aspect 886 wherein said step for identifying a set of one or more complete and correct algorithms comprises a step for demonstrating a valid algorithm for each data type associated with the language.

888. The method of aspect 887, wherein said step for demonstrating a valid algorithm for each data type comprises a step for utilizing automated algebraic analysis.

889. The method of aspect 887, wherein said step for demonstrating a valid algorithm for each data type comprises a step for utilizing approximation.

890. The method of aspect 862, further comprising: repeating said step for designing the language after said step for verifying the decidable and complete data flow if decidable and complete data flow is unverifiable.

891. The method of aspect 819, wherein the steps for designing and verifying are repeated iteratively until decidable and complete data flow is verified.

892. The method of aspect 813 wherein said step for employing a finite input/output semantic model comprises a step for generating a software procedure and a corresponding FIOSM for the software procedure.

893. The method of aspect 813 wherein said step for employing a finite input/output semantic model comprises a step for generating a software routine and a corresponding FIOSM for the software routine.

894. The method of aspect 813 wherein said step for employing a finite input/output semantic model comprises a step for generating a software program and a corresponding FIOSM for the software program.

895. The method of aspect 813 wherein said step for employing a finite input/output semantic model comprises a step for generating a software module and a corresponding FIOSM for the software module.

896. The method of aspect 813 wherein said step for employing a finite input/output semantic model comprises a step for generating a software enterprise system and a corresponding FIOSM for the software enterprise system.

897. A method for generating a finite input/output semantic model comprising:
a step for receiving a source program;
a step for parsing the source program into an abstract data structure;
a step for generating a set of code paths based on the abstract data structure;
a step for converting the set of code paths into a set of logically consistent data element models;
a step for utilizing the set of logically consistent data element models to format the finite input/output semantic model including:
   a step for identifying a set of input data elements in the source program,
   a step for identifying a set of output data elements in the source program, and for each set of data elements, a step for creating an input-output pattern expression;
   a step for producing a valid data expression for each set of input data elements; and
   a step for producing a valid data expression for each set of output data elements.

898. The method of aspect 897 wherein the source program is written in a finite input output semantic model compliant programming language.

899. The method of aspect 897 wherein the source program is written in programming language having unambiguous semantics and decidable and complete data flow.

900. The method of aspect 897 wherein the source program is written in programming language having unambiguous semantics and decidable and complete data flow.

901. The method of aspect 897 wherein the source program is written in programming language having unambiguous semantics and decidable and complete data flow.

902. The method of aspect 897 wherein the source program is written in programming language wherein each operator of a set consisting of all operators in the language has unambiguous semantics and is incapable of an invoking infinite code path.

903. The method of aspect 897 wherein the source program is written in programming language wherein each operator of a set consisting of all operators in the language is incapable of an invoking infinite code path.

904. The method of aspect 897 wherein the abstract data structure comprises a parse tree.

905. The method of aspect 897 wherein the abstract data structure comprises a tree model

906. The method of aspect 897 wherein the abstract data structure comprises a directed acyclic graph structure.

907. The method of aspect 904 wherein said step for generating a set of code paths based on the abstract data structure comprises a step for walking the parse tree.

908. The method of aspect 904 wherein said step for generating a set of code paths based on the abstract data structure comprises a step for using a suitable algorithm to walk the parse tree.

909. The method of aspect 908 wherein the suitable algorithm is a model-splitting type algorithm.

910. The method of aspect 909 wherein the model-splitting type algorithm is a member of the Tableau family of algorithms.

911. The method of aspect 908 wherein the suitable algorithm is a book-marking type algorithm.

912. The method of aspect 908 wherein the suitable algorithm is a model search algorithm.

913. The method of aspect 897 wherein each data element model of the set of logically consistent data element models represents one input-output pattern of the source program.

914. The method of aspect 897, wherein the step for converting the set of code paths into a set of logically consistent data element models includes a step for discarding logically inconsistent data element models from the set of code paths.

915. The method of aspect 897, wherein the step for converting the set of code paths into a set of logically consistent data element models includes (i) a step for walking the set of code paths, (ii) a step for generating the set of data element models, and (iii) a step for testing each data element model of the set for data-element consistency.

916. A method comprising:
a step for providing a known programming language; and
a step for modifying the language wherein any program written in the language is finite input output semantic model compliant.

917. The method of aspect 916 wherein the known programming language comprises one of: C, C+, C++, Java, Basic, Pascal, and Fortran.

918. The method of aspect 916, wherein said step for modifying language comprises removing all operators (i) having ambiguous semantics and (ii) being capable of invoking infinite code paths.

919. The method of aspect 917, wherein said step for modifying language comprises removing all operators (i) having ambiguous semantics and (ii) being capable of invoking infinite code paths.

920. The method of aspect 916, wherein said step for modifying an existing software programming language comprises a step for removing all operators capable of invoking infinite code paths.

921. The method of aspect 917, wherein said step for modifying an existing software programming language comprises a step for removing all operators capable of invoking infinite code paths.

922. The method of aspect 918 further a step for comprising replacing the removed operators with one or more alternative operators incapable of invoking infinite loops.

923. The method of aspect 919 further a step for comprising replacing the removed operators with one or more alternative operators incapable of invoking infinite loops.

924. The method of aspect 920 further a step for comprising replacing the removed operators with one or more alternative operators incapable of invoking infinite loops.

925. The method of aspect 921 further a step for comprising replacing the removed operators with one or more alternative operators incapable of invoking infinite loops.

926. The method of aspect 918 further a step for comprising replacing the removed operators with one or more alternative operators having unambiguous semantics.

927. The method of aspect 919 further a step for comprising replacing the removed operators with one or more alternative operators having unambiguous semantics.

928. The method of aspect 920 further a step for comprising replacing the removed operators with one or more alternative operators having unambiguous semantics.

929. The method of aspect 921 further a step for comprising replacing the removed operators with one or more alternative operators having unambiguous semantics.

930. The method of aspect 918 wherein a for loop operator is replaced with “sum” operator.

931. The method of aspect 919 wherein a for loop operator is replaced with “sum” operator.

932. The method of aspect 920 wherein a for loop operator is replaced with “sum” operator.

933. The method of aspect 921 wherein a for loop operator is replaced with “sum” operator.

934. The method of aspect 922 wherein a for loop operator is replaced with “sum” operator.

935. The method of aspect 923 wherein a for loop operator is replaced with “sum” operator.

936. The method of aspect 924 wherein a for loop operator is replaced with “sum” operator.

937. The method of aspect 925 wherein a for loop operator is replaced with “sum” operator.

938. The method of aspect 926 wherein a for loop operator is replaced with “sum” operator.

939. The method of aspect 927 wherein a for loop operator is replaced with “sum” operator.

940. The method of aspect 928 wherein a for loop operator is replaced with “sum” operator.

941. The method of aspect 929 wherein a for loop operator is replaced with “sum” operator.

942. The method of aspect 916, wherein said step for modifying the language comprises redefining one or more data types.

943. The method of aspect 916, wherein said step for modifying the language comprises replacing one or more data types.

944. The method of aspect 917, wherein said step for modifying the language comprises redefining one or more data types.

945. The method of aspect 917, wherein said step for modifying the language comprises replacing one or more data types.

946. The method of aspect 918, wherein said step for modifying the language comprises redefining one or more data types.

947. The method of aspect 918, wherein said step for modifying the language comprises replacing one or more data types.

948. The method of aspect 919, wherein said step for modifying the language comprises redefining one or more data types.

949. The method of aspect 919, wherein said step for modifying the language comprises replacing one or more data types.

950. The method of aspect 920, wherein said step for modifying the language comprises redefining one or more data types.

951. The method of aspect 920, wherein said step for modifying the language comprises replacing one or more data types.

952. The method of aspect 921, wherein said step for modifying the language comprises redefining one or more data types.

953. The method of aspect 921, wherein said step for modifying the language comprises replacing one or more data types.

954. The method of aspect 922, wherein said step for modifying the language comprises redefining one or more data types.

955. The method of aspect 922, wherein said step for modifying the language comprises replacing one or more data types.

956. The method of aspect 923, wherein said step for modifying the language comprises redefining one or more data types.

957. The method of aspect 923, wherein said step for modifying the language comprises replacing one or more data types.

958. The method of aspect 924, wherein said step for modifying the language comprises redefining one or more data types.

959. The method of aspect 924, wherein said step for modifying the language comprises replacing one or more data types.

960. The method of aspect 925, wherein said step for modifying the language comprises redefining one or more data types.

961. The method of aspect 925, wherein said step for modifying the language comprises replacing one or more data types.

962. The method of aspect 926, wherein said step for modifying the language comprises redefining one or more data types.

963. The method of aspect 926, wherein said step for modifying the language comprises replacing one or more data types.

964. The method of aspect 927, wherein said step for modifying the language comprises redefining one or more data types.

965. The method of aspect 927, wherein said step for modifying the language comprises replacing one or more data types.

966. The method of aspect 928, wherein said step for modifying the language comprises redefining one or more data types.

967. The method of aspect 928, wherein said step for modifying the language comprises replacing one or more data types.

968. The method of aspect 929, wherein said step for modifying the language comprises redefining one or more data types.

969. The method of aspect 929, wherein said step for modifying the language comprises replacing one or more data types.

970. The method of aspect 930, wherein said step for modifying the language comprises redefining one or more data types.

971. The method of aspect 930, wherein said step for modifying the language comprises replacing one or more data types.

972. The method of aspect 931, wherein said step for modifying the language comprises redefining one or more data types.

973. The method of aspect 931, wherein said step for modifying the language comprises replacing one or more data types.

974. The method of aspect 932, wherein said step for modifying the language comprises redefining one or more data types.

975. The method of aspect 932, wherein said step for modifying the language comprises replacing one or more data types.

976. The method of aspect 933, wherein said step for modifying the language comprises redefining one or more data types.

977. The method of aspect 933, wherein said step for modifying the language comprises replacing one or more data types.

978. The method of aspect 934, wherein said step for modifying the language comprises redefining one or more data types.

979. The method of aspect 934, wherein said step for modifying the language comprises replacing one or more data types.

980. The method of aspect 935, wherein said step for modifying the language comprises redefining one or more data types.

981. The method of aspect 935, wherein said step for modifying the language comprises replacing one or more data types.

982. The method of aspect 936, wherein said step for modifying the language comprises redefining one or more data types.

983. The method of aspect 936, wherein said step for modifying the language comprises replacing one or more data types.

984. The method of aspect 937, wherein said step for modifying the language comprises redefining one or more data types.

985. The method of aspect 937, wherein said step for modifying the language comprises replacing one or more data types.

986. The method of aspect 938, wherein said step for modifying the language comprises redefining one or more data types.

987. The method of aspect 938, wherein said step for modifying the language comprises replacing one or more data types.

988. The method of aspect 939, wherein said step for modifying the language comprises redefining one or more data types.

989. The method of aspect 939, wherein said step for modifying the language comprises replacing one or more data types.

990. The method of aspect 940, wherein said step for modifying the language comprises redefining one or more data types.

991. The method of aspect 940, wherein said step for modifying the language comprises replacing one or more data types.

992. The method of aspect 941, wherein said step for modifying the language comprises redefining one or more data types.

993. The method of aspect 941, wherein said step for modifying the language comprises replacing one or more data types.

994. The method of aspect 916 further comprising verifying that all programs created in the language have decidable and complete data flow.

995. A method comprising:
a step for providing a known programming language; and
a step for modifying the language wherein the modified language satisfies both a finite code path property and a data flow property.

996. The method of aspect 995, further comprising a step for verifying compliance with the finite code path property.

997. The method of aspect 995, further comprising a step for verifying compliance with the data flow property.

998. The method of aspect 996, further comprising a step for verifying compliance with the data flow property.

999. The method of aspect 995 wherein said step for modifying the language includes redefining one or more data types.

1000. The method of aspect 996 wherein said step for modifying the language includes redefining one or more data types.

1001. The method of aspect 997 wherein said step for modifying the language includes redefining one or more data types.

1002. The method of aspect 998 wherein said step for modifying the language includes redefining one or more data types.

1003. The method of aspect 995 wherein said step for modifying the language includes a step for replacing one or more operators having ambiguous semantics with replacement operators having unambiguous semantics.

1004. The method of aspect 996 wherein said step for modifying the language includes a step for replacing one or more operators having ambiguous semantics with replacement operators having unambiguous semantics.

1005. The method of aspect 997 wherein said step for modifying the language includes a step for replacing one or more operators having ambiguous semantics with replacement operators having unambiguous semantics.

1006. The method of aspect 998 wherein said modifying the language includes a step for replacing one or more operators having ambiguous semantics with replacement operators having unambiguous semantics.

1007. The method of aspect 999 wherein said modifying the language includes a step for replacing one or more operators having ambiguous semantics with replacement operators having unambiguous semantics.

1008. The method of aspect 1000 wherein said modifying the language includes a step for replacing one or more operators having ambiguous semantics with replacement operators having unambiguous semantics.

1009. The method of aspect 1001 wherein said modifying the language includes a step for replacing one or more operators having ambiguous semantics with replacement operators having unambiguous semantics.

1010. The method of aspect 1002 wherein said modifying the language includes a step for replacing one or more operators having ambiguous semantics with replacement operators having unambiguous semantics.

1011. The method of aspect 999 wherein the redefined data types comprise enumerable and non-enumerable data types.

1012. The method of aspect 1000 wherein the redefined data types comprise enumerable and non-enumerable data types.

1013. The method of aspect 1001 wherein the redefined data types comprise enumerable and non-enumerable data types.

1014. The method of aspect 1002 wherein the redefined data types comprise enumerable and non-enumerable data types.

1015. The method of aspect 999 wherein the redefined data types comprise enumerable and non-enumerable data types.

1016. The method of aspect 1011 wherein all data elements of the non-enumerated data types are represented as sets.

1017. The method of aspect 1012 wherein all data elements of the non-enumerated data types are represented as sets.

1018. The method of aspect 1013 wherein all data elements of the non-enumerated data types are represented as sets.

1019. The method of aspect 1014 wherein all data elements of the non-enumerated data types are represented as sets.

1020. The method of aspect 1015 wherein all data elements of the non-enumerated data types are represented as sets.

1021. The method of aspect 1016 wherein all data elements consisting of infinite sets are expressed with a finite lexical notation.

1022. The method of aspect 1017 wherein all data elements consisting of infinite sets are expressed with a finite lexical notation.

1023. The method of aspect 1018 wherein all data elements consisting of infinite sets are expressed with a finite lexical notation.

1024. The method of aspect 1019 wherein all data elements consisting of infinite sets are expressed with a finite lexical notation.

1025. The method of aspect 1020 wherein all data elements consisting of infinite sets are expressed with a finite lexical notation.

1026. The method of aspect 1016 wherein numeric data types are non-enumerated data types and numeric data elements of the numeric data types are expressed using equalities and/or inequalities.

1027. The method of aspect 1017 wherein numeric data types are non-enumerated data types and numeric data elements of the numeric data types are expressed using equalities and/or inequalities.

1028. The method of aspect 1018 wherein numeric data types are non-enumerated data types and numeric data elements of the numeric data types are expressed using equalities and/or inequalities.

1029. The method of aspect 1019 wherein numeric data types are non-enumerated data types and numeric data elements of the numeric data types are expressed using equalities and/or inequalities.

1030. The method of aspect 1020 wherein numeric data types are non-enumerated data types and numeric data elements of the numeric data types are expressed using equalities and/or inequalities.

1031. The method of aspect 996 wherein said verifying compliance with the finite code path property comprises demonstrating all possible code paths within the language can be expressed in a finite tree model.

1032. The method of aspect 1031, wherein the tree model comprises a directed acyclic graph.

1033. The method of aspect 1032 wherein said step for demonstrating all possible code paths within the language comprises a step for generating a tree model using a tableau algorithm.

1034. The method of aspect 1031 wherein said step for demonstrating all possible code paths within the language comprises a step for generating a tree model using a tableau algorithm.

1035. The method of aspect 1031 wherein said step for demonstrating all possible code paths within the language comprises a step for generating a tree model using a model search algorithm.

1036. The method of aspect 997 wherein said further comprising verifying compliance with the finite code path property comprises a step for demonstrating all possible code paths within the language can be expressed in a finite tree model.

1037. The method of aspect 1036, wherein the tree model comprises a directed acyclic graph.

1038. The method of aspect 1037 wherein said step for demonstrating all possible code paths within the language comprises a step for generating a tree model using a tableau algorithm.

1039. The method of aspect 1036 wherein said step for demonstrating all possible code paths within the language comprises generating a tree model using a tableau algorithm.

1040. The method of aspect 1036 wherein said step for demonstrating all possible code paths within the language comprises a step for generating a tree model using a model search algorithm.

1041. The method of aspect 998 wherein said step for verifying compliance with the finite code path property comprises a step for demonstrating all possible code paths within the language can be expressed in a finite tree model.

1042. The method of aspect 1041, wherein the tree model comprises a directed acyclic graph.

1043. The method of aspect 1042 wherein said step for demonstrating all possible code paths within the language comprises a step for generating a tree model using a tableau algorithm.

1044. The method of aspect 1041 wherein said step for demonstrating all possible code paths within the language comprises a step for generating a tree model using a tableau algorithm.

1045. The method of aspect 1041 wherein said step for demonstrating all possible code paths within the language comprises a step for generating a tree model using a model search algorithm.

1046. The method of aspect 997, wherein said step for verifying compliance with the data flow property comprises a step for identifying a set of one or more complete and correct algorithms that can determine the value of any data element in the set of all programs written in the language.

1047. The method of aspect 1046 wherein said step for identifying a set of one or more complete and correct algorithms comprises a step for demonstrating a valid algorithm for each data type associated with the language.

1048. The method of aspect 1047, wherein said step for demonstrating a valid algorithm for each data type comprises a step for utilizing automated algebraic analysis.

1049. The method of aspect 1047, wherein said step for demonstrating a valid algorithm for each data type comprises utilizing approximation.

1050. The method of aspect 1001, wherein said step for verifying compliance with the data flow property comprises step for identifying a set of one or more complete and correct algorithms that can determine the value of any data element in the set of all programs written in the language.

1051. The method of aspect 1050 wherein said step for identifying a set of one or more complete and correct algorithms comprises a step for demonstrating a valid algorithm for each data type associated with the language.

1052. The method of aspect 1051, wherein said step for demonstrating a valid algorithm for each data type comprises utilizing automated algebraic analysis.

1053. The method of aspect 1051, wherein said step for demonstrating a valid algorithm for each data type comprises utilizing approximation.

1054. The method of aspect 1005, wherein said step for verifying compliance with the data flow property comprises a step for identifying a set of one or more complete and correct algorithms that can determine the value of any data element in the set of all programs written in the language.

1055. The method of aspect 1054 wherein said step for identifying a set of one or more complete and correct algorithms comprises a step for demonstrating a valid algorithm for each data type associated with the language.

1056. The method of aspect 1055, wherein said step for demonstrating a valid algorithm for each data type comprises a step for utilizing automated algebraic analysis.

1057. The method of aspect 1055, wherein said step for demonstrating a valid algorithm for each data type comprises utilizing approximation.

1058. The method of aspect 996, further comprising: a step for repeating modifying the language after said step for verifying compliance with the finite code path property if compliance with the finite code path property is unverifiable.

1059. The method of aspect 1058, wherein the steps for modifying and verifying are repeated iteratively until the finite code path property is verified.

1060. The method of aspect 998, further comprising: a step for repeating modifying the language after said step for verifying compliance with the finite code path property if compliance with the finite code path property is unverifiable.

1061. The method of aspect 1060, wherein the steps of modifying and verifying are repeated iteratively until the finite code path property is verified.

1062. The method of aspect 1000, further comprising: a step for repeating modifying the language after said step for verifying compliance with the finite code path property if compliance with the finite code path property is unverifiable.

1063. The method of aspect 1062, wherein the steps for modifying and verifying are repeated iteratively until the finite code path property is verified.

1064. The method of aspect 1002, further comprising: step for repeating modifying the language after said step for verifying compliance with the finite code path property if compliance with the finite code path property is unverifiable.

1065. The method of aspect 1064, wherein the steps for modifying and verifying are repeated iteratively until the finite code path property is verified.

1066. The method of aspect 1004, further comprising: a step for repeating modifying the language after said step for verifying compliance with the finite code path property if compliance with the finite code path property is unverifiable.

1067. The method of aspect 1066, wherein the steps for modifying and verifying are repeated iteratively until the finite code path property is verified.

1068. The method of aspect 1008, further comprising: a step for repeating modifying the language after said step for verifying compliance with the finite code path property if compliance with the finite code path property is unverifiable.

1069. The method of aspect 1068, wherein the steps for modifying and verifying are repeated iteratively until the finite code path property is verified.

1070. The method of aspect 1010, further comprising: a step for repeating modifying the language after said step for verifying compliance with the finite code path property if compliance with the finite code path property is unverifiable.

1071. The method of aspect 1070, wherein the steps of modifying and verifying are repeated iteratively until the finite code path property is verified.

1072. The method of aspect 1012, further comprising: a step for repeating modifying the language after said step for verifying compliance with the finite code path property if compliance with the finite code path property is unverifiable.

1073. The method of aspect 1072, wherein the steps of modifying and verifying are repeated iteratively until the finite code path property is verified.

1074. The method of aspect 1014, further comprising: a step for repeating modifying the language after said step for verifying compliance with the finite code path property if compliance with the finite code path property is unverifiable.

1075. The method of aspect 1074, wherein the steps of modifying and verifying are repeated iteratively until the finite code path property is verified.

1076. The method of aspect 1017, further comprising: a step for repeating modifying the language after said step for verifying compliance with the finite code path property if compliance with the finite code path property is unverifiable.

1077. The method of aspect 1076, wherein the steps of modifying and verifying are repeated iteratively until the finite code path property is verified.

1078. The method of aspect 1019, further comprising: a step for repeating modifying the language after said step for verifying compliance with the finite code path property if compliance with the finite code path property is unverifiable.

1079. The method of aspect 1078, wherein the steps of modifying and verifying are repeated iteratively until the finite code path property is verified.

1080. The method of aspect 1022, further comprising: a step for repeating modifying the language after said step for verifying compliance with the finite code path property if compliance with the finite code path property is unverifiable.

1081. The method of aspect 1080, wherein the steps of modifying and verifying are repeated iteratively until the finite code path property is verified.

1082. The method of aspect 1024, further comprising: a step for repeating modifying the language after said step for verifying compliance with the finite code path property if compliance with the finite code path property is unverifiable.

1083. The method of aspect 1082, wherein the steps of modifying and verifying are repeated iteratively until the finite code path property is verified.

1084. The method of aspect 1027, further comprising: a step for repeating modifying the language after said step for verifying compliance with the finite code path property if compliance with the finite code path property is unverifiable.

1085. The method of aspect 1084, wherein the steps of modifying and verifying are repeated iteratively until the finite code path property is verified.

1086. The method of aspect 1029, further comprising: a step for repeating modifying the language after said step for verifying compliance with the finite code path property if compliance with the finite code path property is unverifiable.

1087. The method of aspect 1086, wherein the steps of modifying and verifying are repeated iteratively until the finite code path property is verified.

1088. The method of aspect 1031, further comprising: a step for repeating modifying the language after said step for verifying compliance with the finite code path property if compliance with the finite code path property is unverifiable.

1089. The method of aspect 1088, wherein the steps of modifying and verifying are repeated iteratively until the finite code path property is verified.

1090. The method of aspect 1032, further comprising: a step for repeating modifying the language after said step for verifying compliance with the finite code path property if compliance with the finite code path property is unverifiable.

1091. The method of aspect 1090, wherein the steps of modifying and verifying are repeated iteratively until the finite code path property is verified.

1092. The method of aspect 1033, further comprising: a step for repeating modifying the language after said step for verifying compliance with the finite code path property if compliance with the finite code path property is unverifiable.

1093. The method of aspect 1092, wherein the steps of modifying and verifying are repeated iteratively until the finite code path property is verified.

1094. The method of aspect 1034, further comprising: a step for repeating modifying the language after said step for verifying compliance with the finite code path property if compliance with the finite code path property is unverifiable.

1095. The method of aspect 1094, wherein the steps of modifying and verifying are repeated iteratively until the finite code path property is verified.

1096. The method of aspect 1035, further comprising: a step for repeating modifying the language after said step for verifying compliance with the finite code path property if compliance with the finite code path property is unverifiable.

1097. The method of aspect 1096, wherein the steps of modifying and verifying are repeated iteratively until the finite code path property is verified.

1098. The method of aspect 1041, further comprising: a step for repeating modifying the language after said step for verifying compliance with the finite code path property if compliance with the finite code path property is unverifiable.

1099. The method of aspect 1098, wherein the steps of modifying and verifying are repeated iteratively until the finite code path property is verified.

1100. The method of aspect 1044, further comprising: a step for repeating modifying the language after said step for verifying compliance with the finite code path property if compliance with the finite code path property is unverifiable.

1101. The method of aspect 1100, wherein the steps of modifying and verifying are repeated iteratively until the finite code path property is verified.

1102. The method of aspect 1045, further comprising: a step for repeating modifying the language after said step for verifying compliance with the finite code path property if compliance with the finite code path property is unverifiable.

1103. The method of aspect 1102, wherein the steps of modifying and verifying are repeated iteratively until the finite code path property is verified.

1104. A method of creating a computer language wherein a set of all programs created in the language have a decidable and complete data flow comprising:
a step of designing the language including defining operators and defining data types; and
a step of verifying the decidable and complete data flow.

1105. The method of aspect 1104 wherein the steps of defining operators includes only specifying operators whose semantics are not ambiguous or cannot invoke infinite code paths.

1106. The method of aspect 1104 wherein the data types comprise enumerable and non-enumerable data types.

1107. The method of aspect 1106 wherein all data elements of the non-enumerated data types are represented as sets.

1108. The method of aspect 1107 wherein all data elements consisting of infinite sets are expressed with a finite lexical notation.

1109. The method of aspect 1107 wherein numeric data types are non-enumerated data types and numeric data elements of the numeric data types are expressed using equalities and/or inequalities.

1110. The method of aspect 1104 wherein the steps of verifying decidable and complete data flow comprises steps for verifying both a code path quality and a data flow quality of the language.

1111. The method of aspect 1110 wherein said step of verifying a code path quality comprises a step for demonstrating all possible code paths within the language can be expressed in a finite tree model.

1112. The method of aspect 1111, wherein the tree model comprises a directed acyclic graph.

1113. The method of aspect 1111 wherein said step for demonstrating all possible code paths within the language comprises a step for generating a tree model using a tableau algorithm.

1114. The method of aspect 1110, wherein step for verifying the data flow quality further comprises identifying a set of one or more complete and correct algorithms that can determine the value of any data element in the set of all programs written in the language.

1115. The method of aspect 1114 wherein said step for identifying a set of one or more complete and correct algorithms comprises a step for demonstrating a valid algorithm for each data type associated with the language.

1116. The method of aspect 1115, wherein said step for demonstrating a valid algorithm for each data type comprises a step for utilizing automated algebraic analysis.

1117. The method of aspect 1115, wherein said step for demonstrating a valid algorithm for each data type comprises a step for utilizing approximation.

1118. The method of aspect 1104, further comprising: repeating said step for designing the language after said step for verifying the decidable and complete data flow if decidable and complete data flow is unverifiable.

1119. The method of aspect 1118, wherein the steps for designing and verifying are repeated iteratively until decidable and complete data flow is verified.

1120. The method of aspect 1104 wherein the step for defining control flow operators includes only a step for specifying control flow operators whose semantics are not ambiguous or result in infinite code paths.

1121. A method of creating a computer language wherein a finite input output model (FIOSM) can be generated for all programs created in the language, the method comprising:
a step for designing the language including defining operators and defining data types; and
a step for verifying an FIOSM can be generated for all programs created in the language by verifying all programs have decidable and complete data flow.

1122. The method of aspect 1121 wherein defining operators includes only specifying operators whose semantics are not ambiguous or cannot invoke infinite code paths.

1123. The method of aspect 1121 wherein the data types comprise enumerable and non-enumerable data types.

1124. The method of aspect 1123 wherein all data elements of the non-enumerated data types are represented as sets.

1125. The method of aspect 1124 wherein all data elements consisting of infinite sets are expressed with a finite lexical notation.

1126. The method of aspect 1124 wherein numeric data types are non-enumerated data types and numeric data elements of the numeric data types are expressed using equalities and/or inequalities.

1127. The method of aspect 1121 wherein the step for verifying decidable and complete data flow comprises a step for verifying both a code path quality and a data flow quality of the language.

1128. The method of aspect 1127 wherein said step for verifying a code path quality comprises a step for demonstrating all possible code paths within the language can be expressed in a finite tree model.

1129. The method of aspect 1128, wherein the tree model comprises a directed acyclic graph.

1130. The method of aspect 1128, wherein said step for demonstrating all possible code paths within the language comprises a step for generating a tree model using a tableau algorithm.

1131. The method of aspect 1127, wherein the step for verifying the data flow quality further comprises a step for identifying a set of one or more complete and correct algorithms that can determine the value of any data element in the set of all programs written in the language.

1132. The method of aspect 1131, wherein said step for identifying a set of one or more complete and correct algorithms comprises a step for demonstrating a valid algorithm for each data type associated with the language.

1133. The method of aspect 1132, wherein said step for demonstrating a valid algorithm for each data type comprises utilizing automated algebraic analysis.

1134. The method of aspect 1132, wherein said step for demonstrating a valid algorithm for each data type comprises utilizing approximation.

1135. The method of aspect 1121, further comprising: repeating said step for designing the language after said step for verifying the decidable and complete data flow if decidable and complete data flow is unverifiable.

1136. The method of aspect 1133, wherein the steps of designing and verifying are repeated iteratively until decidable and complete data flow is verified.

1137. The method of aspect 1121 wherein the step for defining operators includes only specifying operators whose semantics are not ambiguous or result in infinite code paths.

1138. A method of creating the computer language wherein each operator of a set consisting of all operators in the language has unambiguous semantics and is incapable of an invoking infinite code path, the method comprising:
a step for designing the language including a step for defining the set of all operators and a step for defining a set of data types; and
a step for verifying that each operator of the set of operators is incapable of invoking an infinite loop.

1139. The method of aspect 1138 wherein the set of data types includes enumerable and non-enumerable data types.

1140. The method of aspect 1139 wherein all data elements of the non-enumerated data types are represented as sets.

1141. The method of aspect 1140 wherein all data elements consisting of infinite sets are expressed with a finite lexical notation.

1142. The method of aspect 1140 wherein numeric data types are non-enumerated data types and numeric data elements of the numeric data types are expressed using equalities and/or inequalities.

1143. The method of aspect 1138 wherein said verifying that each operator of the set of operators is incapable of invoking an infinite loop comprises verifying both a code path quality and a data flow quality of the language.

1144. The method of aspect 1143 wherein said verifying a code path quality comprises demonstrating all possible code paths within the language can be expressed in a finite tree model.

1145. The method of aspect 1144, wherein the tree model comprises a directed acyclic graph.

1146. The method of aspect 1144 wherein said demonstrating all possible code paths within the language comprises generating a tree model using a tableau algorithm.

1147. The method of aspect 1143, wherein the step for verifying the data flow quality further comprises a step for identifying a set of one or more complete and correct algorithms that can determine the value of any data element in the set of all programs written in the language.

1148. The method of aspect 1146 wherein said step for identifying a set of one or more complete and correct algorithms comprises a step for demonstrating a valid algorithm for each data type associated with the language.

1149. The method of aspect 1148, wherein said step for demonstrating a valid algorithm for each data type comprises utilizing automated algebraic analysis.

1150. The method of aspect 1148, wherein said step for demonstrating a valid algorithm for each data type comprises utilizing approximation.

1151. The method of aspect 1138, further comprising: repeating said step for designing the language after said step for verifying that each operator of the set of operators is incapable of invoking an infinite loop is unverifiable.

1152. The method of aspect 1151, wherein the steps for designing and verifying are repeated iteratively until decidable and complete data flow is verified.

1153. A method of creating the computer language wherein each operator of a set consisting of all operators in the language is incapable of invoking an infinite code path, the method comprising:
a step for designing the language including defining the set of all operators and defining a set of data types; and
a step for verifying that each operator of the set of operators is incapable of invoking an infinite loop.

1154. The method of aspect 1153 wherein the set of data types includes enumerable and non-enumerable data types.

1155. The method of aspect 1154 wherein all data elements of the non-enumerated data types are represented as sets.

1156. The method of aspect 1155 wherein all data elements consisting of infinite sets are expressed with a finite lexical notation.

1157. The method of aspect 1155 wherein numeric data types are non-enumerated data types and numeric data elements of the numeric data types are expressed using equalities and/or inequalities.

1158. The method of aspect 1153 wherein said step for verifying that each operator of the set of operators is incapable of invoking an infinite loop comprises a step for verifying both a code path quality and a data flow quality of the language.

1159. The method of aspect 1158 wherein said step for verifying a code path quality comprises a step for demonstrating all possible code paths within the language can be expressed in a finite tree model.

1160. The method of aspect 1159, wherein the tree model comprises a directed acyclic graph.

1161. The method of aspect 1159 wherein said step for demonstrating all possible code paths within the language comprises a step for generating a tree model using a tableau algorithm.

1162. The method of aspect 1158, wherein the step for verifying the data flow quality further comprises a step for identifying a set of one or more complete and correct algorithms that can determine the value of any data element in the set of all programs written in the language.

1163. The method of aspect 1162 wherein said step for identifying a set of one or more complete and correct algorithms comprises a step for demonstrating a valid algorithm for each data type associated with the language.

1164. The method of aspect 1163, wherein said step for demonstrating a valid algorithm for each data type comprises utilizing automated algebraic analysis.

1165. The method of aspect 1163, wherein said step for demonstrating a valid algorithm for each data type comprises utilizing approximation.

1166. The method of aspect 1153, further comprising: repeating said step for designing the language after said that each operator of the set of operators is incapable of invoking an infinite loop is unverifiable.

1167. The method of aspect 1166, wherein the steps for designing and verifying are repeated iteratively until decidable and complete data flow is verified.

1168. A method comprising:
a step for creating a finite input output semantic model (FIOSM) compliant programming language;
a step for generating a software program in the FIOSM compliant language; and
a step for generating a FIOSM for the program.

1169. The method of aspect 1168 wherein said step for creating a finite input output semantic model (FIOSM) compliant programming language further comprises:
a step for providing a known programming language; and
a step for modifying the known program language into the FIOSM compliant language wherein any program written in the language is FIOSM compliant.

1170. The method of aspect 1169 wherein the known programming language comprises one of: C, C+, C++, Java, Basic, Pascal, and Fortran.

1171. The method of aspect 1169, wherein said step for modifying language comprises a step for removing all operators (i) having ambiguous semantics and (ii) being capable of invoking infinite code paths.

1172. The method of aspect 1170, wherein said step for modifying language comprises a step for removing all operators (i) having ambiguous semantics and (ii) being capable of invoking infinite code paths.

1173. The method of aspect 1169, wherein said step for modifying an existing software programming language comprises a step for removing all operators capable of invoking infinite code paths.

1174. The method of aspect 1170, wherein said step for modifying an existing software programming language comprises a step for removing all operators capable of invoking infinite code paths.

1175. The method of aspect 1171 further comprising a step for replacing the removed operators with one or more alternative operators incapable of invoking infinite loops.

1176. The method of aspect 1172 further comprising a step for replacing the removed operators with one or more alternative operators incapable of invoking infinite loops.

1177. The method of aspect 1173 further comprising a step for replacing the removed operators with one or more alternative operators incapable of invoking infinite loops.

1178. The method of aspect 1174 further comprising a step for replacing the removed operators with one or more alternative operators incapable of invoking infinite loops.

1179. The method of aspect 1171 further comprising a step for replacing the removed operators with one or more alternative operators having unambiguous semantics.

1180. The method of aspect 1172 further comprising a step for replacing the removed operators with one or more alternative operators having unambiguous semantics.

1181. The method of aspect 1173 further comprising a step for replacing the removed operators with one or more alternative operators having unambiguous semantics.

1182. The method of aspect 1174 further comprising a step for replacing the removed operators with one or more alternative operators having unambiguous semantics.

1183. The method of aspect 1171 wherein a for loop operator is replaced with “sum” operator.

1184. The method of aspect 1172 wherein a for loop operator is replaced with “sum” operator.

1185. The method of aspect 1173 wherein a for loop operator is replaced with “sum” operator.

1186. The method of aspect 1174 wherein a for loop operator is replaced with “sum” operator.

1187. The method of aspect 1175 wherein a for loop operator is replaced with “sum” operator.

1188. The method of aspect 1176 wherein a for loop operator is replaced with “sum” operator.

1189. The method of aspect 1177 wherein a for loop operator is replaced with “sum” operator.

1190. The method of aspect 1178 wherein a for loop operator is replaced with “sum” operator.

1191. The method of aspect 1179 wherein a for loop operator is replaced with “sum” operator.

1192. The method of aspect 1180 wherein a for loop operator is replaced with “sum” operator.

1193. The method of aspect 1181 wherein a for loop operator is replaced with “sum” operator.

1194. The method of aspect 1181 wherein a for loop operator is replaced with “sum” operator.

1195. The method of aspect 1169, wherein said step for modifying the language comprises redefining one or more data types.

1196. The method of aspect 1169, wherein said step for modifying the language comprises replacing one or more data types.

1197. The method of aspect 1170, wherein said step for modifying the language comprises redefining one or more data types.

1198. The method of aspect 1170, wherein said step for modifying the language comprises replacing one or more data types.

1199. The method of aspect 1171, wherein said step for modifying the language comprises redefining one or more data types.

1200. The method of aspect 1171, wherein said step for modifying the language comprises replacing one or more data types.

1201. The method of aspect 1172, wherein said step for modifying the language comprises redefining one or more data types.

1202. The method of aspect 1172, wherein said step for modifying the language comprises replacing one or more data types.

1203. The method of aspect 1173, wherein said step for modifying the language comprises redefining one or more data types.

1204. The method of aspect 1173, wherein said step for modifying the language comprises replacing one or more data types.

1205. The method of aspect 1174, wherein said step for modifying the language comprises redefining one or more data types.

1206. The method of aspect 1174, wherein said step for modifying the language comprises replacing one or more data types.

1207. The method of aspect 1175, wherein said step for modifying the language comprises redefining one or more data types.

1208. The method of aspect 1175, wherein said step for modifying the language comprises replacing one or more data types.

1209. The method of aspect 1176, wherein said step for modifying the language comprises redefining one or more data types.

1210. The method of aspect 1176, wherein said step for modifying the language comprises replacing one or more data types.

1211. The method of aspect 1177, wherein said step for modifying the language comprises redefining one or more data types.

1212. The method of aspect 1177, wherein said step for modifying the language comprises replacing one or more data types.

1213. The method of aspect 1178, wherein said step for modifying the language comprises redefining one or more data types.

1214. The method of aspect 1178, wherein said step for modifying the language comprises replacing one or more data types.

1215. The method of aspect 1179, wherein said step for modifying the language comprises redefining one or more data types.

1216. The method of aspect 1179, wherein said step for modifying the language comprises replacing one or more data types.

1217. The method of aspect 1180, wherein said step for modifying the language comprises redefining one or more data types.

1218. The method of aspect 1180, wherein said step for modifying the language comprises replacing one or more data types.

1219. The method of aspect 1181, wherein said step for modifying the language comprises redefining one or more data types.

1220. The method of aspect 1181, wherein said step for modifying the language comprises replacing one or more data types.

1221. The method of aspect 1182, wherein said step for modifying the language comprises redefining one or more data types.

1222. The method of aspect 1182, wherein said step for modifying the language comprises replacing one or more data types.

1223. The method of aspect 1183, wherein said step for modifying the language comprises redefining one or more data types.

1224. The method of aspect 1183, wherein said step for modifying the language comprises replacing one or more data types.

1225. The method of aspect 1184, wherein said step for modifying the language comprises redefining one or more data types.

1226. The method of aspect 1184, wherein said step for modifying the language comprises replacing one or more data types.

1227. The method of aspect 1185, wherein said step for modifying the language comprises redefining one or more data types.

1228. The method of aspect 1185, wherein said step for modifying the language comprises replacing one or more data types.

1229. The method of aspect 1186, wherein said step for modifying the language comprises redefining one or more data types.

1230. The method of aspect 1186, wherein said step for modifying the language comprises replacing one or more data types.

1231. The method of aspect 1187, wherein said step for modifying the language comprises redefining one or more data types.

1232. The method of aspect 1187, wherein said step for modifying the language comprises replacing one or more data types.

1233. The method of aspect 1188, wherein said step for modifying the language comprises redefining one or more data types.

1234. The method of aspect 1188, wherein said step for modifying the language comprises replacing one or more data types.

1235. The method of aspect 1189, wherein said step for modifying the language comprises redefining one or more data types.

1236. The method of aspect 1189, wherein said step for modifying the language comprises replacing one or more data types.

1237. The method of aspect 1190, wherein said step for modifying the language comprises redefining one or more data types.

1238. The method of aspect 1190, wherein said step for modifying the language comprises replacing one or more data types.

1239. The method of aspect 1190, wherein said step for modifying the language comprises redefining one or more data types.

1240. The method of aspect 1191, wherein said step for modifying the language comprises replacing one or more data types.

1241. The method of aspect 1191, wherein said step for modifying the language comprises redefining one or more data types.

1242. The method of aspect 1192, wherein said step for modifying the language comprises replacing one or more data types.

1243. The method of aspect 1192, wherein said step for modifying the language comprises redefining one or more data types.

1244. The method of aspect 1193, wherein said step for modifying the language comprises replacing one or more data types.

1245. The method of aspect 1193, wherein said step for modifying the language comprises redefining one or more data types.

1246. The method of aspect 1194, wherein said step for modifying the language comprises replacing one or more data types.

1247. The method of aspect 1169 further comprising a step for verifying that all programs created in the language have decidable and complete data flow.

1248. The method of aspect 1168 wherein said step for creating a finite input output semantic model (FIOSM) compliant programming language further comprises:
a step for designing the language including defining operators and defining data types; and
a step for verifying an FIOSM can be generated for all programs created in the language by verifying all programs have decidable and complete data flow.

1249. The method of aspect 1248 wherein step for defining operators includes only specifying operators whose semantics are not ambiguous or cannot invoke infinite code paths.

1250. The method of aspect 1248 wherein the data types comprise enumerable and non-enumerable data types.

1251. The method of aspect 1250 wherein all data elements of the non-enumerated data types are represented as sets.

1252. The method of aspect 1251 wherein all data elements consisting of infinite sets are expressed with a finite lexical notation.

1253. The method of aspect 1251 wherein numeric data types are non-enumerated data types and numeric data elements of the numeric data types are expressed using equalities and/or inequalities.

1254. The method of aspect 1248 wherein the step for verifying decidable and complete data flow comprises verifying both a code path quality and a data flow quality of the language.

1255. The method of aspect 1254 wherein said step for verifying a code path quality comprises a step for demonstrating all possible code paths within the language can be expressed in a finite tree model.

1256. The method of aspect 1255, wherein the tree model comprises a directed acyclic graph.

1257. The method of aspect 1255, wherein said step for demonstrating all possible code paths within the language comprises a step for generating a tree model using a tableau algorithm.

1258. The method of aspect 1254, wherein the step for verifying the data flow quality further comprises a step for identifying a set of one or more complete and correct algorithms that can determine the value of any data element in the set of all programs written in the language.

1259. The method of aspect 1258, wherein said step for identifying a set of one or more complete and correct algorithms comprises a step for demonstrating a valid algorithm for each data type associated with the language.

1260. The method of aspect 1259, wherein said step for demonstrating a valid algorithm for each data type comprises utilizing automated algebraic analysis.

1261. The method of aspect 1259, wherein said demonstrating a valid algorithm for each data type comprises utilizing approximation.

1262. The method of aspect 1248, further comprising: a step for repeating said designing the language after said step for verifying the decidable and complete data flow if decidable and complete data flow is unverifiable.

1263. The method of aspect 1260, wherein the steps for designing and verifying are repeated iteratively until decidable and complete data flow is verified.

1264. The method of aspect 1248 wherein the step for defining operators includes only specifying operators whose semantics are not ambiguous or result in infinite code paths.

1265. The method of aspect 1168 wherein said step for creating a finite input output semantic model (FIOSM) compliant programming language further comprises:
a step for defining the set of all operators in the language
a step for defining a set of all data types in the language; and
a step for verifying that each operator of the set of operators is incapable of invoking an infinite loop.

1266. The method of aspect 1265 wherein the set of data types includes enumerable and non-enumerable data types.

1267. The method of aspect 1266 wherein all data elements of the non-enumerated data types are represented as sets.

1268. The method of aspect 1267 wherein all data elements consisting of infinite sets are expressed with a finite lexical notation.

1269. The method of aspect 1267 wherein numeric data types are non-enumerated data types and numeric data elements of the numeric data types are expressed using equalities and/or inequalities.

1270. The method of aspect 1265 wherein said step for verifying that each operator of the set of operators is incapable of invoking an infinite loop comprises a step for verifying both a code path quality and a data flow quality of the language.

1271. The method of aspect 1270 wherein said step for verifying a code path quality comprises a step for demonstrating all possible code paths within the language can be expressed in a finite tree model.

1272. The method of aspect 1271, wherein the tree model comprises a directed acyclic graph.

1273. The method of aspect 1271 wherein said step for demonstrating all possible code paths within the language comprises a step for generating a tree model using a tableau algorithm.

1274. The method of aspect 1270, wherein the step for verifying the data flow quality further comprises a step for identifying a set of one or more complete and correct algorithms that can determine the value of any data element in the set of all programs written in the language.

1275. The method of aspect 1274 wherein said step for identifying a set of one or more complete and correct algorithms comprises a step for demonstrating a valid algorithm for each data type associated with the language.

1276. The method of aspect 1275, wherein said step for demonstrating a valid algorithm for each data type comprises utilizing automated algebraic analysis.

1277. The method of aspect 1275, wherein said step for demonstrating a valid algorithm for each data type comprises utilizing approximation.

1278. The method of aspect 1265, further comprising: repeating said step for creating a finite input output semantic model (FIOSM) compliant programming language is unverifiable.

1279. The method of aspect 1278, wherein the steps for creating and verifying are repeated iteratively until decidable and complete data flow is verified.

1280. The method of aspect 1168 wherein said step for generating a FIOSM for the program further comprises:
a step for generating a parse tree;
a step for generating a code path set based on the parse tree;
a step for generating a path data model set using the code path set; and
a step for generating a finite input/output semantic model (FIOSM) from the path data model set.

1281. The method of aspect 1280, wherein the step for the generation of a finite input/output semantic model dictates that the software has a completely decidable data flow.

1282. The method of aspect 1280 wherein said step for generating a parse tree comprises a step for parsing the source code of the program.

1283. The method of aspect 1280 wherein the parse tree comprises a directed acyclic graph structure (DAG).

1284. The method of aspect 1280, wherein said step for generating a code path set based on the parse tree comprises a step for utilizing a suitable algorithm to walk the parse tree.

1285. The method of aspect 1280, wherein the code path set comprises condition free code path trees.

1286. The method of aspect 1284, wherein the suitable algorithm comprises a tableau algorithm.

1287. The method of aspect 1284, wherein the suitable algorithm comprises a book-marking algorithm.

1288. The method of aspect 1280, wherein the path data model set comprises a plurality of logically consistent data element models.

1289. The method of aspect 1288, wherein said step for generating a path data model set using the code path set includes a step for discarding any logically inconsistent data element models.

1290. The method of aspect 1280, wherein said step for generating a path data model set using the code path set comprises for each code path set element: (i) a step for walking the code path parse tree of the code path set element; (ii) a step for recording assignments and constraints for the code path set element.

1291. The method of aspect 1280, wherein said step for generating a path data model set using the code path set comprises a step for converting the code path set into a set of logically consistent data model elements.

1292. The method of aspect 1280, wherein said step for generating a finite input/output semantic model (FIOSM) from the path data model set comprises: (i) a step for identifying a set of input data elements in the program; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1293. The method of aspect 1292, wherein said step for formatting a FIOSM from the path data model set further comprises: a step for eliminating intermediate data elements.

1294. The method of aspect 1168 wherein the program does not include operators having ambiguous semantics or control flow operators capable of invoking infinite code paths.

1295. The method of aspect 1168 wherein the software program includes a plurality of operators wherein no combination of operators of the plurality of operators are capable of invoking an infinite code path in the computer program.

1296. The method of aspect 1168 wherein the software program comprises at least 1,000 lines.

1297. The method of aspect 1168 wherein the software program comprises at least 10,000 lines.

1298. The method of aspect 1168 wherein the software program comprises at least 100,000 lines.

1299. The method of aspect 1168 wherein the software program comprises at least 1,000,000 lines.

1300. The method of aspect 1168, wherein the FIOSM consists of all possible inputs to the program and all possible outputs the software program can generate based on all possible inputs.

1301. The method of aspect 1168 wherein said step for generating a FIOSM for the program further comprises:
a step for parsing the source code of the program to generate a parse tree;
a step for generating a code path set using the parse tree;
a step for generating a path data model set using the code path set; and
a step for formatting a FIOSM from the path data model set.

1302. The method of aspect 1301, wherein the parse tree comprises a directed acyclic graph structure (DAG).

1303. The method of aspect 1301, wherein the parse tree comprises a directed acyclic graph structure (DAG).

1304. The method of aspect 1301, wherein the parse tree comprises a tree model

1305. The method of aspect 1301, wherein said step for generating code path sets using the parse tree comprises utilizing a suitable algorithm to walk the parse tree.

1306. The method of aspect 1306 wherein the suitable algorithm comprises a tableau algorithm.

1307. The method of aspect 1306 wherein the suitable algorithm comprises a model search algorithm.

1308. The method of aspect 1301 wherein the path data model set comprises a plurality of logically consistent data element models.

1309. The method of aspect 1306 wherein said step for generating a path data model set using the code path set includes a step for discarding any logically inconsistent data element models.

1310. The method of aspect 1301 wherein said step for generating a path data model set using the code path sets comprises for each code path set element: (i) a step for walking the code path parse tree of the code path set element; (ii) a step for recording assignments and constraints for the code path set element.

1311. The method of aspect 1301 wherein said step for formatting a FIOSM from the path data model set comprises: (i) a step for identifying a set of input data elements in the program; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1312. The method of aspect 1311, wherein said step for formatting a FIOSM from the path data model set further comprises: a step for eliminating intermediate data elements.

1313. The method of aspect 1168 wherein said step for generating a FIOSM for the program further comprises:
a step for parsing the program into an abstract data structure;
a step for generating a set of code paths based on the abstract data structure;
a step for converting the set of code paths into a set of logically consistent data element models;
a step for utilizing the set of logically consistent data element models to format the finite input/output semantic model including:
   a step for identifying a set of input data elements in the program,
   a step for identifying a set of output data elements in the program, and for each set of data elements, a step for creating an input-output pattern expression;
   a step for producing a valid data expression for each set of input data elements; and
   a step for producing a valid data expression for each set of output data elements.

1314. The method of aspect 1313 wherein the abstract data structure comprises a parse tree.

1315. The method of aspect 1313 wherein the abstract data structure comprises a tree model.

1316. The method of aspect 1313 wherein the abstract data structure comprises a directed acyclic graph structure.

1317. The method of aspect 1314 wherein said creating an input-output pattern expression generating a set of code paths based on the abstract data structure comprises a step for walking the parse tree.

1318. The method of aspect 1314 wherein said step for generating a set of code paths based on the abstract data structure comprises using a suitable algorithm to walk the parse tree.

1319. The method of aspect 1318 wherein the suitable algorithm is a model-splitting type algorithm.

1320. The method of aspect 1319 wherein the model-splitting type algorithm is a member of the Tableau family of algorithms.

1321. The method of aspect 1318 wherein the suitable algorithm is a book-marking type algorithm.

1322. The method of aspect 1318 wherein the suitable algorithm is a model search algorithm.

1323. The method of aspect 1313 wherein each data element model of the set of logically consistent data element models represents one input-output pattern of the source program.

1324. The method of aspect 1313, wherein the step for converting the set of code paths into a set of logically consistent data element models includes a step for discarding logically inconsistent data element models from the set of code paths.

1325. The method of aspect 1313, wherein the step for converting the set of code paths into a set of logically consistent data element models includes (i) a step for walking the set of code paths, (ii) a step for generating the set of data element models, and (iii) a step for testing each data element model of the set for data-element consistency.

1326. A method comprising:
a step for creating a finite input output semantic model (FIOSM) compliant programming language;
a step for generating a software procedure in the FIOSM compliant language; and
a step for generating a FIOSM for the procedure.

1327. The method of aspect 1326 wherein said step for generating a FIOSM for the procedure further comprises:
a step for generating a parse tree;
a step for generating a code path set based on the parse tree;
a step for generating a path data model set using the code path set; and
a step for generating a finite input/output semantic model (FIOSM) from the path data model set.

1328. The method of aspect 1327, wherein the step of the generation of a finite input/output semantic model dictates that the software has a completely decidable data flow.

1329. The method of aspect 1327 wherein said step for generating a parse tree comprises parsing the source code of the procedure.

1330. The method of aspect 1327 wherein the parse tree comprises a directed acyclic graph structure (DAG).

1331. The method of aspect 1327, wherein said step for generating a code path set based on the parse tree comprises utilizing a suitable algorithm to walk the parse tree.

1332. The method of aspect 1327, wherein the code path set comprises condition free code path trees.

1333. The method of aspect 1331, wherein the suitable algorithm comprises a tableau algorithm.

1334. The method of aspect 1331, wherein the suitable algorithm comprises a book-marking algorithm.

1335. The method of aspect 1327, wherein the path data model set comprises a plurality of logically consistent data element models.

1336. The method of aspect 1335, wherein said step for generating a path data model set using the code path set includes a step for discarding any logically inconsistent data element models.

1337. The method of aspect 1327, wherein said step for generating a path data model set using the code path set comprises for each code path set element: (i) a step for walking the code path parse tree of the code path set element; (ii) a step for recording assignments and constraints for the code path set element.

1338. The method of aspect 1327, wherein said step for generating a path data model set using the code path set comprises a step for converting the code path set into a set of logically consistent data model elements.

1339. The method of aspect 1327, wherein said step for generating a finite input/output semantic model (FIOSM) from the path data model set comprises: (i) a step for identifying a set of input data elements in the procedure; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1340. The method of aspect 1339, wherein said step for formatting a FIOSM from the path data model set further comprises: a step for eliminating intermediate data elements.

1341. The method of aspect 1316 wherein the procedure does not include operators having ambiguous semantics or control flow operators capable of invoking infinite code paths.

1342. The method of aspect 1316 wherein the software procedure includes a plurality of operators wherein no combination of operators of the plurality of operators are capable of invoking an infinite code path in the procedure.

1343. The method of aspect 1316 wherein the software procedure comprises at least 1,000 lines.

1344. The method of aspect 1316 wherein the software procedure comprises at least 10,000 lines.

1345. The method of aspect 1316 wherein the software procedure comprises at least 100,000 lines.

1346. The method of aspect 1316 wherein the software procedure comprises at least 1,000,000 lines.

1347. The method of aspect 1316, wherein the FIOSM consists of all possible inputs to the procedure and all possible outputs the software procedure can generate based on all possible inputs.

1348. The method of aspect 1316 wherein said step for generating a FIOSM for the procedure further comprises:
a step for parsing the source code of the procedure to generate a parse tree;
a step for generating a code path set using the parse tree;
a step for generating a path data model set using the code path set; and
a step for formatting a FIOSM from the path data model set.

1349. The method of aspect 1348, wherein the parse tree comprises a directed acyclic graph structure (DAG).

1350. The method of aspect 1348, wherein the parse tree comprises a directed acyclic graph structure (DAG).

1351. The method of aspect 1348, wherein the parse tree comprises a tree model

1352. The method of aspect 1348, wherein said step for generating code path sets using the parse tree comprises utilizing a suitable algorithm to walk the parse tree.

1353. The method of aspect 1353 wherein the suitable algorithm comprises a tableau algorithm.

1354. The method of aspect 1353 wherein the suitable algorithm comprises a model search algorithm.

1355. The method of aspect 1338 wherein the path data model set comprises a plurality of logically consistent data element models.

1356. The method of aspect 1353 wherein said step for generating a path data model set using the code path set includes a step for discarding any logically inconsistent data element models.

1357. The method of aspect 1348 wherein said step for generating a path data model set using the code path sets comprises for each code path set element: (i) a step for walking the code path parse tree of the code path set element; (ii) a step for recording assignments and constraints for the code path set element.

1358. The method of aspect 1348 wherein said step for formatting a FIOSM from the path data model set comprises: (i) a step for identifying a set of input data elements in the procedure; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1359. The method of aspect 1358, wherein said step for formatting a FIOSM from the path data model set further comprises: a step for eliminating intermediate data elements.

1360. The method of aspect 1366 wherein said step for generating a FIOSM for the procedure further comprises:
a step for parsing the procedure into an abstract data structure;
a step for generating a set of code paths based on the abstract data structure;
a step for converting the set of code paths into a set of logically consistent data element models;
a step for utilizing the set of logically consistent data element models to format the finite input/output semantic model including:
   a step for identifying a set of input data elements in the procedure,
   a step for identifying a set of output data elements in the procedure, and for each set of data elements, a step for creating an input-output pattern expression;
   a step for producing a valid data expression for each set of input data elements; and
   a step for producing a valid data expression for each set of output data elements.

1361. The method of aspect 1360 wherein the abstract data structure comprises a parse tree.

1362. The method of aspect 1360 wherein the abstract data structure comprises a tree model

1363. The method of aspect 1360 wherein the abstract data structure comprises a directed acyclic graph structure.

1364. The method of aspect 1361 wherein said step for generating a set of code paths based on the abstract data structure comprises a step for walking the parse tree.

1365. The method of aspect 1361 wherein said step for generating a set of code paths based on the abstract data structure comprises using a suitable algorithm to walk the parse tree.

1366. The method of aspect 1365 wherein the suitable algorithm is a model-splitting type algorithm.

1367. The method of aspect 1366 wherein the model-splitting type algorithm is a member of the Tableau family of algorithms.

1368. The method of aspect 1365 wherein the suitable algorithm is a book-marking type algorithm.

1369. The method of aspect 1365 wherein the suitable algorithm is a model search algorithm.

1370. The method of aspect 1360 wherein each data element model of the set of logically consistent data element models represents one input-output pattern of the source procedure.

1371. The method of aspect 1360, wherein step for converting the set of code paths into a set of logically consistent data element models includes a step for discarding logically inconsistent data element models from the set of code paths.

1372. The method of aspect 1360, wherein the step for converting the set of code paths into a set of logically consistent data element models includes (i) a step for walking the set of code paths, (ii) a step for generating the set of data element models, and (iii) a step for testing each data element model of the set for data-element consistency.

1373. A method comprising:
a step for creating a finite input output semantic model (FIOSM) compliant programming language;
a step for generating a software routine in the FIOSM compliant language; and
a step for generating a FIOSM for the routine.

1374. The method of aspect 1373 wherein said step for generating a FIOSM for the routine further comprises:
a step for generating a parse tree;
a step for generating a code path set based on the parse tree;
a step for generating a path data model set using the code path set; and
a step for generating a finite input/output semantic model (FIOSM) from the path data model set.

1375. The method of aspect 1374, wherein the generation of a finite input/output semantic model dictates that the software has a completely decidable data flow.

1376. The method of aspect 1374 wherein said step for generating a parse tree comprises a step for parsing the source code of the routine.

1377. The method of aspect 1374 wherein the parse tree comprises a directed acyclic graph structure (DAG).

1378. The method of aspect 1374, wherein said step for generating a code path set based on the parse tree comprises utilizing a suitable algorithm to walk the parse tree.

1379. The method of aspect 1374, wherein the code path set comprises condition free code path trees.

1380. The method of aspect 1378, wherein the suitable algorithm comprises a tableau algorithm.

1381. The method of aspect 1378, wherein the suitable algorithm comprises a book-marking algorithm.

1382. The method of aspect 1374, wherein the path data model set comprises a plurality of logically consistent data element models.

1383. The method of aspect 1382, wherein said step for generating a path data model set using the code path set includes a step for discarding any logically inconsistent data element models.

1384. The method of aspect 1374, wherein said step for generating a path data model set using the code path set comprises for each code path set element: (i) a step for walking the code path parse tree of the code path set element; (ii) a step for recording assignments and constraints for the code path set element.

1385. The method of aspect 1374, wherein said step for generating a path data model set using the code path set comprises a step for converting the code path set into a set of logically consistent data model elements.

1386. The method of aspect 1374, wherein said step for generating a finite input/output semantic model (FIOSM) from the path data model set comprises: (i) a step for identifying a set of input data elements in the routine; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1387. The method of aspect 1386, wherein said step for formatting a FIOSM from the path data model set further comprises: a step for eliminating intermediate data elements.

1388. The method of aspect 1373 wherein the routine does not include operators having ambiguous semantics or control flow operators capable of invoking infinite code paths.

1389. The method of aspect 1373 wherein the software routine includes a plurality of operators wherein no combination of operators of the plurality of operators are capable of invoking an infinite code path in the routine.

1390. The method of aspect 1373 wherein the software routine comprises at least 1,000 lines.

1391. The method of aspect 1373 wherein the software routine comprises at least 10,000 lines.

1392. The method of aspect 1373 wherein the software routine comprises at least 100,000 lines.

1393. The method of aspect 1373 wherein the software routine comprises at least 1,000,000 lines.

1394. The method of aspect 1373, wherein the FIOSM consists of all possible inputs to the routine and all possible outputs the software routine can generate based on all possible inputs.

1395. The method of aspect 1373 wherein said step for generating a FIOSM for the routine further comprises:
a step for parsing the source code of the routine to generate a parse tree;
a step for generating a code path set using the parse tree;
a step for generating a path data model set using the code path set; and
a step for formatting a FIOSM from the path data model set.

1396. The method of aspect 1395, wherein the parse tree comprises a directed acyclic graph structure (DAG).

1397. The method of aspect 1395, wherein the parse tree comprises a directed acyclic graph structure (DAG).

1398. The method of aspect 1395, wherein the parse tree comprises a tree model

1399. The method of aspect 1395, wherein said step for generating code path sets using the parse tree comprises utilizing a suitable algorithm to walk the parse tree.

1400. The method of aspect 1400 wherein the suitable algorithm comprises a tableau algorithm.

1401. The method of aspect 1400 wherein the suitable algorithm comprises a model search algorithm.

1402. The method of aspect 1395 wherein the path data model set comprises a plurality of logically consistent data element models.

1403. The method of aspect 1400 wherein said step for generating a path data model set using the code path set includes a step for discarding any logically inconsistent data element models.

1404. The method of aspect 1395 wherein said step for generating a path data model set using the code path sets comprises for each code path set element: (i) a step for walking the code path parse tree of the code path set element; (ii) a step for recording assignments and constraints for the code path set element.

1405. The method of aspect 1395 wherein said step for formatting a FIOSM from the path data model set comprises: (i) a step for identifying a set of input data elements in the routine; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1406. The method of aspect 1405, wherein said step for formatting a FIOSM from the path data model set further comprises: a step for eliminating intermediate data elements.

1407. The method of aspect 1373 wherein said step for generating a FIOSM for the routine further comprises:
a step for parsing the routine into an abstract data structure;
a step for generating a set of code paths based on the abstract data structure;
a step for converting the set of code paths into a set of logically consistent data element models;
a step for utilizing the set of logically consistent data element models to format the finite input/output semantic model including:
   a step for identifying a set of input data elements in the routine,
   a step for identifying a set of output data elements in the routine, and for each set of data elements, a step for creating an input-output pattern expression;
   a step for producing a valid data expression for each set of input data elements; and
   a step for producing a valid data expression for each set of output data elements.

1408. The method of aspect 1407 wherein the abstract data structure comprises a parse tree.

1409. The method of aspect 1407 wherein the abstract data structure comprises a tree model

1410. The method of aspect 1407 wherein the abstract data structure comprises a directed acyclic graph structure.

1411. The method of aspect 1408 wherein said step for generating a set of code paths based on the abstract data structure comprises a step for walking the parse tree.

1412. The method of aspect 1408 wherein said step for generating a set of code paths based on the abstract data structure comprises using a suitable algorithm to walk the parse tree.

1413. The method of aspect 1412 wherein the suitable algorithm is a model-splitting type algorithm.

1414. The method of aspect 1413 wherein the model-splitting type algorithm is a member of the Tableau family of algorithms.

1415. The method of aspect 1412 wherein the suitable algorithm is a book-marking type algorithm.

1416. The method of aspect 1412 wherein the suitable algorithm is a model search algorithm.

1417. The method of aspect 1407 wherein each data element model of the set of logically consistent data element models represents one input-output pattern of the source routine.

1418. The method of aspect 1407, wherein step for converting the set of code paths into a set of logically consistent data element models includes a step for discarding logically inconsistent data element models from the set of code paths.

1419. The method of aspect 1407, wherein step for converting the set of code paths into a set of logically consistent data element models includes (i) a step for walking the set of code paths, (ii) a step for generating the set of data element models, and (iii) a step for testing each data element model of the set for data-element consistency.

1420. A method comprising:
a step for creating a finite input output semantic model (FIOSM) compliant programming language;
a step for generating a software enterprise system in the FIOSM compliant language; and
a step for generating a FIOSM for the enterprise system.

1421. The method of aspect 1420 wherein said step for generating a FIOSM for the enterprise system further comprises:
a step for generating a parse tree;
a step for generating a code path set based on the parse tree;
a step for generating a path data model set using the code path set; and
a step for generating a finite input/output semantic model (FIOSM) from the path data model set.

1422. The method of aspect 1421, wherein the generation of a finite input/output semantic model dictates that the software has a completely decidable data flow.

1423. The method of aspect 1421 wherein said step for generating a parse tree comprises a step for parsing the source code of the enterprise system.

1424. The method of aspect 1421 wherein the parse tree comprises a directed acyclic graph structure (DAG).

1425. The method of aspect 1421, wherein said step for generating a code path set based on the parse tree comprises utilizing a suitable algorithm to walk the parse tree.

1426. The method of aspect 1421, wherein the code path set comprises condition free code path trees.

1427. The method of aspect 1425, wherein the suitable algorithm comprises a tableau algorithm.

1428. The method of aspect 1425, wherein the suitable algorithm comprises a book-marking algorithm.

1429. The method of aspect 1421, wherein the path data model set comprises a plurality of logically consistent data element models.

1430. The method of aspect 1329, wherein said step for generating a path data model set using the code path set includes a step for discarding any logically inconsistent data element models.

1431. The method of aspect 1321, wherein said step for generating a path data model set using the code path set comprises for each code path set element: (i) a step for walking the code path parse tree of the code path set element; (ii) a step for recording assignments and constraints for the code path set element.

1432. The method of aspect 1321, wherein said a step for generating a path data model set using the code path set comprises a step for converting the code path set into a set of logically consistent data model elements.

1433. The method of aspect 1321, wherein said step for generating a finite input/output semantic model (FIOSM) from the path data model set comprises: (i) a step for identifying a set of input data elements in the enterprise system; (ii) identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1434. The method of aspect 1333, wherein said step for formatting a FIOSM from the path data model set further comprises: a step for eliminating intermediate data elements.

1435. The method of aspect 1420 wherein the enterprise system does not include operators having ambiguous semantics or control flow operators capable of invoking infinite code paths.

1436. The method of aspect 1420 wherein the software enterprise system includes a plurality of operators wherein no combination of operators of the plurality of operators are capable of invoking an infinite code path in the enterprise system.

1437. The method of aspect 1420 wherein the software enterprise system comprises at least 1,000 lines.

1438. The method of aspect 1420 wherein the software enterprise system comprises at least 10,000 lines.

1439. The method of aspect 1420 wherein the software enterprise system comprises at least 100,000 lines.

1440. The method of aspect 1420 wherein the software enterprise system comprises at least 1,000,000 lines.

1441. The method of aspect 1420, wherein the FIOSM consists of all possible inputs to the enterprise system and all possible outputs the software enterprise system can generate based on all possible inputs.

1442. The method of aspect 1420 wherein said step for generating a FIOSM for the enterprise system further comprises:
a step for parsing the source code of the enterprise system to generate a parse tree;
a step for generating a code path set using the parse tree;
a step for generating a path data model set using the code path set; and
a step for formatting a FIOSM from the path data model set.

1443. The method of aspect 1442, wherein the parse tree comprises a directed acyclic graph structure (DAG).

1444. The method of aspect 1442, wherein the parse tree comprises a directed acyclic graph structure (DAG).

1445. The method of aspect 1442, wherein the parse tree comprises a tree model.

1446. The method of aspect 1442, wherein said step for generating code path sets using the parse tree comprises utilizing a suitable algorithm to walk the parse tree.

1447. The method of aspect 1447 wherein the suitable algorithm comprises a tableau algorithm.

1448. The method of aspect 1447 wherein the suitable algorithm comprises a model search algorithm.

1449. The method of aspect 1442 wherein the path data model set comprises a plurality of logically consistent data element models.

1450. The method of aspect 1447 wherein said step for generating a path data model set using the code path set includes a step for discarding any logically inconsistent data element models.

1451. The method of aspect 1442 wherein said step for generating a path data model set using the code path sets comprises for each code path set element: (i) a step for walking the code path parse tree of the code path set element; (ii) a step for recording assignments and constraints for the code path set element.

1452. The method of aspect 1442 wherein said step for formatting a FIOSM from the path data model set comprises: (i) a step for identifying a set of input data elements in the enterprise system; (ii) a step for identifying a set of output data elements; (iii) for each member of the path data model set, a step for creating a input-output pattern expression; (iv) for each input data element, a step for generating an input data expression and adding it to an input set; and (v) for each output data element, a step for generating an output data expression and adding it to an output set.

1453. The method of aspect 1352, wherein said step for formatting a FIOSM from the path data model set further comprises: a step for eliminating intermediate data elements.

1454. The method of aspect 1420 wherein said step for generating a FIOSM for the enterprise system further comprises:
a step for parsing the enterprise system into an abstract data structure;
a step for generating a set of code paths based on the abstract data structure;
a step for converting the set of code paths into a set of logically consistent data element models;
a step for utilizing the set of logically consistent data element models to format the finite input/output semantic model including:
   a step for identifying a set of input data elements in the enterprise system,
   a step for identifying a set of output data elements in the enterprise system, and for each set of data elements, a step for creating an input-output pattern expression;
   a step for producing a valid data expression for each set of input data elements; and
   a step for producing a valid data expression for each set of output data elements.

1455. The method of aspect 1454 wherein the abstract data structure comprises a parse tree.

1456. The method of aspect 1454 wherein the abstract data structure comprises a tree model.

1457. The method of aspect 1454 wherein the abstract data structure comprises a directed acyclic graph structure.

1458. The method of aspect 1455 wherein said step for generating a set of code paths based on the abstract data structure comprises a step for walking the parse tree.

1459. The method of aspect 1455 wherein said step for generating a set of code paths based on the abstract data structure comprises using a suitable algorithm to walk the parse tree.

1460. The method of aspect 1459 wherein the suitable algorithm is a model-splitting type algorithm.

1461. The method of aspect 1460 wherein the model-splitting type algorithm is a member of the Tableau family of algorithms.

1462. The method of aspect 1459 wherein the suitable algorithm is a book-marking type algorithm.

1463. The method of aspect 1459 wherein the suitable algorithm is a model search algorithm.

1464. The method of aspect 1454 wherein each data element model of the set of logically consistent data element models represents one input-output pattern of the source enterprise system.

1465. The method of aspect 1454, wherein step for converting the set of code paths into a set of logically consistent data element models includes a step for discarding logically inconsistent data element models from the set of code paths.

1466. The method of aspect 1454, wherein the step for converting the set of code paths into a set of logically consistent data element models includes (i) a step for walking the set of code paths, (ii) a step for generating the set of data element models, and (iii) a step for testing each data element model of the set for data-element consistency.

1467. A method of creating an FIOSM compliant programming language comprising:
a step for designing a programming language;
a step for defining a finite input output semantic model; and
a step for verifying code path and data flow qualities of the programming language.

1468. The method of aspect 1467, wherein said step for designing a programming language includes a step for precluding control flow operators capable of causing ambiguous or infinite code paths in programs written in the language.

1469. The method of aspect 1467, wherein said step for designing a programming language includes a step for converting an existing computer language by modifying existing control flow operators to prevent invocation of infinite looping.

1470. The method of aspect 1467, wherein said step for designing a programming language includes a step for converting an existing computer language to eliminate control flow operators capable of causing ambiguous or infinite code paths in programs written in the language.

1471. The method of aspect 1467, wherein said a step for designing a programming language includes a step for specifying operators that cannot invoke looping.

1472. The method of aspect 1467, wherein the programming language does not include one or more of the following operators: “for”; “if-then-else”; “while-do”; “goto”; “procedure calls”; and any other operator that has equivalent functionality as the foregoing.

1473. The method of aspect 1467, wherein said step for defining a finite input output semantic model includes: a step for generating all possible data constraint expressions; a step for generating an input-output pattern of data expressions; and a step for generating the finite input output model comprising all possible input-output data patterns.

1474. The method of aspect 1472, wherein said step for generating an input-output pattern of data expressions comprises a step for generating a data expression for each data type.

1475. The method of aspect 1473 wherein each data type specified for use in the language has a data constraint expression associated with the data type, each data expression (i) being lexically finite and (ii) representing a defined set of values.

1476. The method of aspect 1472, wherein infinite sets are expressed with a finite lexical notation for applicable data constraint expressions.

1477. The method of aspect 1475, wherein the finite lexical notation includes equalities and inequalities.

1478. The method of aspect 1467 wherein said step for verifying code path and data flow qualities of the programming language includes a step for demonstrating all codes paths written in the language result in a directed acyclic graph representation (DAG).

1479. The method of aspect 1477, wherein a tableau algorithm is utilized to generate the DAG.

1480. The method of aspect 1467 further comprising a step for generating a finite input output semantic model for a software program written in the language.

1481. The method of aspect 1479 comprising:
a step for parsing the source code of a program to generate a parse tree;
a step for generating code path sets using the parse tree;
a step for generating a path data model set using the code path sets; and
a step for formatting a FIOSM from the path data model set.

1482. A method comprising:
a step for providing a software program having fully decidable data flow; and
a step for representing the program in a parse tree.

1483. The method of aspect 1482, wherein the parse tree comprises a tree model.

1484. The method of aspect 1482, wherein the parse tree comprises a directed acyclic graph (DAG).

1485. The method of aspect 1482 wherein the software program is written in a finite input output model compliant programming language.

1486. The method of aspect 1482 further comprises a step for walking the parse tree to generate code path sets utilizing a suitable algorithm.

1487. The method aspect 1486, wherein the suitable algorithm comprises a tableau algorithm.

1488. The method of aspect 1486, wherein the suitable algorithm comprises a tree model algorithm.

1489. The method of aspect 1482 further comprises a step for generating code path sets using the parse tree.

1490. The method of aspect 1482 further comprises a step for generating a path data model set using the code path sets.

1491. The method of aspect 1482 further comprises a step for formatting a FIOSM from the path data model set.

1492. A method comprising:
a step for providing a software procedure having fully decidable data flow; and
a step for representing the procedure in a parse tree.

1493. The method of aspect 1492, wherein the parse tree comprises a tree model.

1494. The method of aspect 1492, wherein the parse tree comprises a directed acyclic graph (DAG).

1495. The method of aspect 1492 wherein the software procedure is written in a finite input output model compliant programming language.

1496. The method of aspect 1492 further comprises a step for walking the parse tree to generate code path sets utilizing a suitable algorithm.

1497. The method aspect 1496, wherein the suitable algorithm comprises a tableau algorithm.

1498. The method of aspect 1496, wherein the suitable algorithm comprises a tree model algorithm.

1499. The method of aspect 1492 further comprises a step for generating code path sets using the parse tree.

1500. The method of aspect 1492 further comprises a step for generating a path data model set using the code path sets.

1501. The method of aspect 1492 further comprises formatting a FIOSM from the path data model set.

1502. A method comprising:
a step for providing a software routine having fully decidable data flow; and
a step for representing the routine in a parse tree.

1503. The method of aspect 1502, wherein the parse tree comprises a tree model.

1504. The method of aspect 1502, wherein the parse tree comprises a directed acyclic graph (DAG).

1505. The method of aspect 1502 wherein the software routine is written in a finite input output model compliant programming language.

1506. The method of aspect 1502 further comprises a step for walking the parse tree to generate code path sets utilizing a suitable algorithm.

1507. The method aspect 1506, wherein the suitable algorithm comprises a tableau algorithm.

1508. The method of aspect 1506, wherein the suitable algorithm comprises a tree model algorithm.

1509. The method of aspect 1502 further comprises a step for generating code path sets using the parse tree.

1510. The method of aspect 1502 further comprises a step for generating a path data model set using the code path sets.

1511. The method of aspect 1502 further comprises a step for formatting a FIOSM from the path data model set.

1512. A method comprising:
a step for providing a software module having fully decidable data flow; and
a step for representing the module in a parse tree.

1513. The method of aspect 1512, wherein the parse tree comprises a tree model.

1514. The method of aspect 1512, wherein the parse tree comprises a directed acyclic graph (DAG).

1515. The method of aspect 1512 wherein the software module is written in a finite input output model compliant programming language.

1516. The method of aspect 1512 further comprises a step for walking the parse tree to generate code path sets utilizing a suitable algorithm.

1517. The method aspect 1516, wherein the suitable algorithm comprises a tableau algorithm.

1518. The method of aspect 1516, wherein the suitable algorithm comprises a tree model algorithm.

1519. The method of aspect 1512 further comprises a step for generating code path sets using the parse tree.

1520. The method of aspect 1512 further comprises a step for generating a path data model set using the code path sets.

1521. The method of aspect 1512 further comprises a step for formatting a FIOSM from the path data model set.

1522. A method comprising:
a step for providing a software enterprise system having fully decidable data flow; and
a step for representing the enterprise system in a parse tree.

1523. The method of aspect 1522, wherein the parse tree comprises a tree model.

1524. The method of aspect 1522, wherein the parse tree comprises a directed acyclic graph (DAG).

1525. The method of aspect 1522 wherein the software enterprise system is written in a finite input output model compliant programming language.

1526. The method of aspect 1522 further comprises a step for walking the parse tree to generate code path sets utilizing a suitable algorithm.

1527. The method aspect 1526, wherein the suitable algorithm comprises a tableau algorithm.

1528. The method of aspect 1526, wherein the suitable algorithm comprises a tree model algorithm.

1529. The method of aspect 1522 further comprises a step for generating code path sets using the parse tree.

1530. The method of aspect 1522 further comprises a step for generating a path data model set using the code path sets.

1531. The method of aspect 1522 further comprises a step for formatting a FIOSM from the path data model set.

1532. A method of developing software comprising:
a step for generating a finite input/output semantic model for the software; and
   a step for using the model for ensuring quality of the software.

1533. One or more general purpose computing machines collectively comprising (i) one or more storage devices having one or more sets of instructions stored thereon, and (ii) one or more processors adapted to execute the one or more sets of instructions, wherein the execution of the one or more sets of instructions includes:
generating a parse tree;
generating a code path set based on the parse tree;
generating a path data model set using the code path set; and
   generating a finite input/output semantic model (FIOSM) from the path data model set.

1534. The one or more general purpose computing machines of aspect 1533, wherein the generation of a finite input/output semantic model dictates that the software has a completely decidable data flow.

1535. The one or more general purpose computing machines of aspect 1533 wherein said generating a parse tree comprises parsing the source code of a software procedure.

1536. The one or more general purpose computing machines of aspect 1533 wherein said generating a parse tree comprises parsing the source code of a software program.

1537. The one or more general purpose computing machines of aspect 1533 wherein the parse tree comprises a directed acyclic graph structure (DAG).

1538. The one or more general purpose computing machines of aspect 1535, wherein the source code is written in a FIOSM compliant programming language.

1539. The one or more general purpose computing machines of aspect 1536, wherein the source code is written in a FIOSM compliant programming language.

1540. The one or more general purpose computing machines of aspect 1533, wherein said generating a code path set based on the parse tree comprises utilizing a suitable algorithm to walk the parse tree.

1541. The one or more general purpose computing machines of aspect 1533, wherein the code path set comprises condition free code path trees.

1542. The one or more general purpose computing machines of aspect 1540, wherein the suitable algorithm comprises a tableau algorithm.

1543. The one or more general purpose computing machines of aspect 1540, wherein the suitable algorithm comprises a book-marking algorithm.

1544. The one or more general purpose computing machines of aspect 1533, wherein the path data model set comprises a plurality of logically consistent data element models.

1545. The one or more general purpose computing machines of aspect 1544, wherein said generating a path data model set using the code path set includes discarding any logically inconsistent data element models.

1546. The one or more general purpose computing machines of aspect 1533, wherein said generating a path data model set using the code path set comprises for each code path set element: (i) walking the code path parse tree of the code path set element; (ii) recording assignments and constraints for the code path set element.

1547. The one or more general purpose computing machines of aspect 1533, wherein said generating a path data model set using the code path set comprises converting the code path set into a set of logically consistent data model elements.

1548. The one or more general purpose computing machines of aspect 1533, wherein said generating a finite input/output semantic model (FIOSM) from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

1549. The one or more general purpose computing machines of aspect 1548, wherein said formatting a FIOSM from the path data model set further comprises: eliminating intermediate data elements.

1550. One or more general purpose computing machines collectively comprising (i) one or more storage devices having one or more sets of instructions stored thereon and (ii) one or more processors adapted to execute the one or more sets of instructions, wherein the execution of the one or more sets of instructions includes: generating a finite input output model (FIOSM) for a predetermined software program written in an FIOSM-compliant language.

1551. The one or more general purpose computing machines of aspect 1550, wherein the sets of instructions further cause the one or more general purpose computing machines to create a FIOSM compliant language.

1552. The one or more general purpose computing machines of aspect 1550, wherein the sets of instructions further cause the one or more general purpose computing machines to modify an existing computer language to be an FIOSM compliant language.

1553. The one or more general purpose computing machines of aspect 1550, wherein the sets of instructions further cause the one or more general purpose computing machines to modify an existing non-FIOSM compliant computer language to be an FIOSM compliant language.

1554. The one or more general purpose computing machines of aspect 1550, wherein wherein the sets of instructions further cause the one or more general purpose computing machines to generate a FIOSM further causes the one or more general purpose computing machines to:
parse the source code of the program to generate a parse tree;
generate a code path set using the parse tree;
generate a path data model set using the code path set; and
format a FIOSM from the path data model set.

1555. The one or more general purpose computing machines of aspect 1550, wherein the FIOSM consists of all possible inputs to the software program and all possible outputs the software program can generate based on all possible inputs.

1556. The one or more general purpose computing machines of aspect 1555, wherein the parse tree comprises a directed acyclic graph structure (DAG).

1557. The one or more general purpose computing machines of aspect 1554, wherein the parse tree comprises a directed acyclic graph structure (DAG).

1558. The one or more general purpose computing machines of aspect 1554, wherein the parse tree comprises a tree model.

1559. The one or more general purpose computing machines of aspect 1554 wherein the instructions to generate code path sets using the parse tree utilize a suitable algorithm to walk the parse tree.

1560. The one or more general purpose computing machines of aspect 1559 wherein the suitable algorithm comprises a tableau algorithm.

1561. The one or more general purpose computing machines of aspect 1559 wherein the suitable algorithm comprises a model search algorithm.

1562. The one or more general purpose computing machines of aspect 1554 wherein the path data model set comprises a plurality of logically consistent data element models.

1563. The one or more general purpose computing machines of aspect 1559 wherein instructions to generate a path data model set using the code path set include instructions to discard any logically inconsistent data element models.

1564. The one or more general purpose computing machines of aspect 1554 wherein the instructions to generate a path data model set using the code path sets further include for each code path set element instructions to: (i) walk the code path parse tree of the code path set element; (ii) record assignments and constraints for the code path set element.

1565. The one or more general purpose computing machines of aspect 1554 wherein the instructions to format a FIOSM from the path data model set include instructions to: (i) identify a set of input data elements in the program; (ii) identify a set of output data elements; (iii) for each member of the path data model set, create a input-output pattern expression; (iv) for each input data element, generate an input data expression and adding it to an input set; and (v) for each output data element, generate an output data expression and adding it to an output set.

1566. The one or more general purpose computing machines of aspect 1565, wherein the instructions to format a FIOSM from the path data model set further instructions to: eliminate intermediate data elements.

1567. One or more general purpose computing machines collectively comprising (i) one or more storage devices having one or more sets of instructions stored thereon and (ii) one or more processors adapted to execute the one or more sets of instructions, wherein the execution of the one or more sets of instructions includes: causing the one or more general purpose computing machines toperform operations employing a finite input/output semantic model (FIOSM).

1568. The one or more general purpose computing machines of aspect 1567 wherein said instructions employing a finite input/output semantic model further include instructions for designing a software programming language having decidable and complete dataflow wherein any and all software procedures created in the programming language can be represented by an FIOSM.

1569. The one or more general purpose computing machines of aspect 1567 wherein said instructions employing a finite input/output semantic model further include instructions for modifying an existing software programming language wherein any and all software procedures created in the programming language can be represented by an FIOSM.

1570. The one or more general purpose computing machines of aspect 1569 wherein the existing software language comprises one of C, C+, C++, Java, Basic, Pascal, and Fortran.

1571. The one or more general purpose computing machines of aspect 1569, wherein said instructions for modifying an existing software programming language further include instructions for removing all operators (i) having ambiguous semantics and (ii) being capable of invoking infinite code paths.

1572. The one or more general purpose computing machines of aspect 1569, wherein said instructions for modifying an existing software programming language further include instructions for removing all operators capable of invoking infinite code paths.

1573. The one or more general purpose computing machines of aspect 1571 wherein the existing software language comprises one of C, C+, C++, Java, Basic, Pascal, and Fortran.

1574. The one or more general purpose computing machines of aspect 1572 wherein the existing software language comprises one of C, C+, C++, Java, Basic, Pascal, and Fortran.

1575. The one or more general purpose computing machines of aspect 1571 further including instructions for replacing the removed operators with one or more alternative operators incapable of invoking infinite loops.

1576. The one or more general purpose computing machines of aspect 1572 further including instructions for replacing the removed operators with one or more alternative operators incapable of invoking infinite loops.

1577. The one or more general purpose computing machines of aspect 1573 further including instructions for replacing the removed operators with one or more alternative operators incapable of invoking infinite loops.

1578. The one or more general purpose computing machines of aspect 1574 further including instructions for replacing the removed operators with one or more alternative operators incapable of invoking infinite loops.

1579. The one or more general purpose computing machines of aspect 1571 further including instructions for replacing the removed operators with one or more alternative operators having unambiguous semantics.

1580. The one or more general purpose computing machines of aspect 1572 further including instructions for replacing the removed operators with one or more alternative operators having unambiguous semantics.

1581. The one or more general purpose computing machines of aspect 1573 further including instructions for replacing the removed operators with one or more alternative operators having unambiguous semantics.

1582. The one or more general purpose computing machines of aspect 1574 further including instructions for replacing the removed operators with one or more alternative operators having unambiguous semantics.

1583. The one or more general purpose computing machines of aspect 1571 wherein the instructions cause, when executed, a for loop operator to be replaced with “sum” operator.

1584. The one or more general purpose computing machines of aspect 1572 wherein the instructions cause, when executed, a for loop operator to be replaced with “sum” operator.

1585. The one or more general purpose computing machines of aspect 1573 wherein the instructions cause, when executed, a for loop operator to be replaced with “sum” operator.

1586. The one or more general purpose computing machines of aspect 1574 wherein the instructions cause, when executed, a for loop operator to be replaced with “sum” operator.

1587. The one or more general purpose computing machines of aspect 1569, wherein said instructions for modifying an existing software programming language includes instructions for redefining one or more data types.

1588. The one or more general purpose computing machines of aspect 1569, wherein said instructions for modifying an existing software programming language include instructions for replacing one or more data types.

1589. The one or more general purpose computing machines of aspect 1570, wherein said instructions for modifying an existing software programming language includes instructions for redefining one or more data types.

1590. The one or more general purpose computing machines of aspect 1570, wherein said instructions for modifying an existing software programming language include instructions for replacing one or more data types.

1591. The one or more general purpose computing machines of aspect 1571, wherein said instructions for modifying an existing software programming language includes instructions for redefining one or more data types.

1592. The one or more general purpose computing machines of aspect 1571, wherein said instructions for modifying an existing software programming language include instructions for replacing one or more data types.

1593. The one or more general purpose computing machines of aspect 1572, wherein said instructions for modifying an existing software programming language includes instructions for redefining one or more data types.

1594. The one or more general purpose computing machines of aspect 1572, wherein said instructions for modifying an existing software programming language include instructions for replacing one or more data types.

1595. The one or more general purpose computing machines of aspect 1573, wherein said instructions for modifying an existing software programming language includes instructions for redefining one or more data types.

1596. The one or more general purpose computing machines of aspect 1573, wherein said instructions for modifying an existing software programming language include instructions for replacing one or more data types.

1597. The one or more general purpose computing machines of aspect 1574, wherein said instructions for modifying an existing software programming language includes instructions for redefining one or more data types.

1598. The one or more general purpose computing machines of aspect 1574, wherein said instructions for modifying an existing software programming language include instructions for replacing one or more data types.

1599. The one or more general purpose computing machines of aspect 1575, wherein said instructions for modifying an existing software programming language includes instructions for redefining one or more data types.

1600. The one or more general purpose computing machines of aspect 1575, wherein said instructions for modifying an existing software programming language include instructions for replacing one or more data types.

1601. The one or more general purpose computing machines of aspect 1576, wherein said instructions for modifying an existing software programming language includes instructions for redefining one or more data types.

1602. The one or more general purpose computing machines of aspect 1576, wherein said instructions for modifying an existing software programming language include instructions for replacing one or more data types.

1603. The one or more general purpose computing machines of aspect 1577, wherein said instructions for modifying an existing software programming language includes instructions for redefining one or more data types.

1604. The one or more general purpose computing machines of aspect 1577, wherein said instructions for modifying an existing software programming language include instructions for replacing one or more data types.

1605. The one or more general purpose computing machines of aspect 1578, wherein said instructions for modifying an existing software programming language includes instructions for redefining one or more data types.

1606. The one or more general purpose computing machines of aspect 1578, wherein said instructions for modifying an existing software programming language include instructions for replacing one or more data types.

1607. The one or more general purpose computing machines of aspect 1579, wherein said instructions for modifying an existing software programming language includes instructions for redefining one or more data types.

1608. The one or more general purpose computing machines of aspect 1579, wherein said instructions for modifying an existing software programming language include instructions for replacing one or more data types.

1609. The one or more general purpose computing machines of aspect 1580, wherein said instructions for modifying an existing software programming language includes instructions for redefining one or more data types.

1610. The one or more general purpose computing machines of aspect 1580, wherein said instructions for modifying an existing software programming language include instructions for replacing one or more data types.

1611. The one or more general purpose computing machines of aspect 1581, wherein said instructions for modifying an existing software programming language includes instructions for redefining one or more data types.

1612. The one or more general purpose computing machines of aspect 1581, wherein said instructions for modifying an existing software programming language include instructions for replacing one or more data types.

1613. The one or more general purpose computing machines of aspect 1582, wherein said instructions for modifying an existing software programming language includes instructions for redefining one or more data types.

1614. The one or more general purpose computing machines of aspect 1582, wherein said instructions for modifying an existing software programming language include instructions for replacing one or more data types.

1615. The one or more general purpose computing machines of aspect 1568 wherein said instructions for designing a software programming language having decidable and complete dataflow include instructions for: (i) defining operators; and (ii) defining data types.

1616. The one or more general purpose computing machines of aspect 1615 further including instructions stored thereon for: verifying the decidable and complete data flow.

1617. The one or more general purpose computing machines of aspect 1615 wherein said instructions for defining operators include only specifying operators whose semantics are not ambiguous or cannot invoke infinite code paths.

1618. The one or more general purpose computing machines of aspect 1616 wherein said instructions for defining operators includes only specifying operators whose semantics are not ambiguous or cannot invoke infinite code paths.

1619. The one or more general purpose computing machines of aspect 1615 wherein the instructions when executed cause the one or more machine to represent the data types as enumerable and non-enumerable data types.

1620. The one or more general purpose computing machines of aspect 1615 that when executed on the one or more general purpose computing machines represent all data elements of the non-enumerated data types as sets.

1621. The one or more general purpose computing machines of aspect 1620 wherein the instructions require that all data elements consisting of infinite sets are expressed with a finite lexical notation when executed on the one or more general purpose computing machines.

1622. The one or more general purpose computing machines of aspect 1620 that, when executed, cause the one or more general purpose computing machines to represent numeric data types are non-enumerated data types and express numeric data elements of the numeric data types using equalities and/or inequalities.

1623. The one or more general purpose computing machines of aspect 1616 wherein the instructions when executed cause the one or more machine to represent the data types as enumerable and non-enumerable data types.

1624. The one or more general purpose computing machines of aspect 1616 that when executed on the one or more general purpose computing machines represent all data elements of the non-enumerated data types as sets.

1625. The one or more general purpose computing machines of aspect 1624 wherein the instructions require that all data elements consisting of infinite sets are expressed with a finite lexical notation when executed on the one or more general purpose computing machines.

1626. The one or more general purpose computing machines of aspect 1624 that, when executed, cause the one or more general purpose computing machines to represent numeric data types are non-enumerated data types and express numeric data elements of the numeric data types using equalities and/or inequalities.

1627. The one or more general purpose computing machines of aspect 1617 wherein the instructions when executed cause the one or more machine to represent the data types as enumerable and non-enumerable data types.

1628. The one or more general purpose computing machines of aspect 1617 that when executed on the one or more general purpose computing machines represent all data elements of the non-enumerated data types as sets.

1629. The one or more general purpose computing machines of aspect 1628 wherein the instructions require that all data elements consisting of infinite sets are expressed with a finite lexical notation when executed on the one or more general purpose computing machines.

1630. The one or more general purpose computing machines of aspect 1628 that, when executed, cause the one or more general purpose computing machines to represent numeric data types are non-enumerated data types and express numeric data elements of the numeric data types using equalities and/or inequalities.

1631. The one or more general purpose computing machines of aspect 1618 wherein the instructions when executed cause the one or more machine to represent the data types as enumerable and non-enumerable data types.

1632. The one or more general purpose computing machines of aspect 1618 that when executed on the one or more general purpose computing machines represent all data elements of the non-enumerated data types as sets.

1633. The one or more general purpose computing machines of aspect 1632 wherein the instructions require that all data elements consisting of infinite sets are expressed with a finite lexical notation when executed on the one or more general purpose computing machines.

1634. The one or more general purpose computing machines of aspect 1632 that, when executed, cause the one or more general purpose computing machines to represent numeric data types are non-enumerated data types and express numeric data elements of the numeric data types using equalities and/or inequalities.

1635. The one or more general purpose computing machines of aspect 1616 wherein said instructions for verifying decidable and complete data flow include instructions for verifying both a code path quality and a data flow quality of the language.

1636. The one or more general purpose computing machines of aspect 1635 wherein said instructions for verifying a code path quality include instructions for demonstrating all possible code paths within the language can be expressed in a finite tree model.

1637. The one or more general purpose computing machines of aspect 1636, wherein the tree model comprises a directed acyclic graph.

1638. The one or more general purpose computing machines of aspect 1636, wherein said instructions for demonstrating all possible code paths within the language include instructions for generating a tree model using a tableau algorithm.

1639. The one or more general purpose computing machines of aspect 1636, wherein said instructions for demonstrating all possible code paths within the language include instructions for generating a tree model using a model search algorithm.

1640. The one or more general purpose computing machines of aspect 1635, wherein instructions for verifying the data flow quality further include instructions for identifying a set of one or more complete and correct algorithms that can determine the value of any data element in the set of all programs written in the language.

1641. The one or more general purpose computing machines of aspect 1640 wherein instructions for identifying a set of one or more complete and correct algorithms include instructions for demonstrating a valid algorithm for each data type associated with the language.

1642. The one or more general purpose computing machines of aspect 1641, wherein instructions for demonstrating a valid algorithm for each data type include instructions for utilizing automated algebraic analysis.

1643. The one or more general purpose computing machines of aspect 1641, wherein instructions for demonstrating a valid algorithm for each data type include instructions for utilizing approximation.

1644. The one or more general purpose computing machines of aspect 1616, further including instructions that when executed on the one or more general purpose computing machines cause the machines to: repeat said designing the language after said verifying the decidable and complete data flow if decidable and complete data flow is unverifiable.

1645. The one or more general purpose computing machines of aspect 1573, wherein the instructions for the operations of designing and verifying are executed by the one or more general purpose computing machines repeatedly until decidable and complete data flow is verified.

1646. The one or more general purpose computing machines of aspect 1567 wherein instructions for employing a finite input/output semantic model include instructions for generating a software procedure and a corresponding FIOSM for the software procedure.

1647. The one or more general purpose computing machines of aspect 1567 wherein instructions for employing a finite input/output semantic model include instructions for generating a software routine and a corresponding FIOSM for the software routine.

1648. The one or more general purpose computing machines of aspect 1567 wherein instructions for employing a finite input/output semantic model include instructions for generating a software program and a corresponding FIOSM for the software program.

1649. The one or more general purpose computing machines of aspect 1567 wherein instructions for employing a finite input/output semantic model include instructions for generating a software module and a corresponding FIOSM for the software module.

1650. The one or more general purpose computing machines of aspect 1567 wherein instructions for employing a finite input/output semantic model include instructions for generating a software enterprise system and a corresponding FIOSM for the software enterprise system.

1651. One or more general purpose computing machines collectively comprising (i) one or more storage devices having one or more sets of instructions stored thereon for generating a finite input/output semantic model and (ii) one or more processors adapted to execute the one or more sets of instructions, wherein the execution of the one or more sets of instructions:
receiving a source program;
parsing the source program into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the source program,
   identifying a set of output data elements in the source program, and for each set of data elements, creating an input-output pattern expression;
producing a valid data expression for each set of input data elements; and producing a valid data expression for each set of output data elements.

1652. The one or more general purpose computing machines of aspect 1651 wherein the abstract data structure comprises a parse tree.

1653. The one or more general purpose computing machines of aspect 1651 wherein the abstract data structure comprises a tree model

1654. The one or more general purpose computing machines of aspect 1651 wherein the abstract data structure comprises a directed acyclic graph structure.

1655. The one or more general purpose computing machines of aspect 1652 wherein instructions for generating a set of code paths based on the abstract data structure include instructions for walking the parse tree.

1656. The one or more general purpose computing machines of aspect 1652 wherein instructions for generating a set of code paths based on the abstract data structure include instructions for using a suitable algorithm to walk the parse tree.

1657. The one or more general purpose computing machines of aspect 1656 wherein the suitable algorithm is a model-splitting type algorithm.

1658. The one or more general purpose computing machines of aspect 1657 wherein the model-splitting type algorithm is a member of the Tableau family of algorithms.

1659. The one or more general purpose computing machines of aspect 1656 wherein the suitable algorithm is a book-marking type algorithm.

1660. The one or more general purpose computing machines of aspect 1656 wherein the suitable algorithm is a model search algorithm.

1661. The one or more general purpose computing machines of aspect 1651 wherein each data element model of the set of logically consistent data element models represents one input-output pattern of the source program.

1662. The one or more general purpose computing machines of aspect 1651, wherein instructions for converting the set of code paths into a set of logically consistent data element models include instructions for discarding logically inconsistent data element models from the set of code paths.

1663. The one or more general purpose computing machines of aspect 1651, wherein instructions for converting the set of code paths into a set of logically consistent data element models include instructions for (i) walking the set of code paths, (ii) generating the set of data element models, and (iii) testing each data element model of the set for data-element consistency.

1664. One or more general purpose computing machines collectively comprising (i) one or more storage devices having one or more sets of instructions stored thereon and (ii) one or more processors adapted to execute the one or more sets of instructions, wherein the execution of the one or more sets of instructions includes:
specifying a known programming language; and
modifying the language wherein any program written in the language is finite input output semantic model compliant.

1665. The one or more general purpose computing machines of aspect 1664 wherein the known programming language comprises one of: C, C+, C++, Java, Basic, Pascal, and Fortran.

1666. The one or more general purpose computing machines of aspect 1664, wherein instructions for modifying language include instructions for removing all operators (i) having ambiguous semantics and (ii) being capable of invoking infinite code paths.

1667. The one or more general purpose computing machines of aspect 1665, wherein instructions for modifying language include instructions for removing all operators (i) having ambiguous semantics and (ii) being capable of invoking infinite code paths.

1668. The one or more general purpose computing machines of aspect 1664, wherein instructions for modifying an existing software programming language include instructions for removing all operators capable of invoking infinite code paths.

1669. The one or more general purpose computing machines of aspect 1665, wherein instructions for modifying an existing software programming language include instructions for removing all operators capable of invoking infinite code paths.

1670. The one or more general purpose computing machines of aspect 1666 wherein the instructions when executed further cause the one or more general purpose computing machines to perform: replacing the removed operators with one or more alternative operators incapable of invoking infinite loops.

1671. The one or more general purpose computing machines of aspect 1667 wherein the instructions when executed further cause the one or more general purpose computing machines to perform: replacing the removed operators with one or more alternative operators incapable of invoking infinite loops.

1672. The one or more general purpose computing machines of aspect 1668 wherein the instructions when executed further cause the one or more general purpose computing machines to perform: replacing the removed operators with one or more alternative operators incapable of invoking infinite loops.

1673. The one or more general purpose computing machines of aspect 1669 wherein the instructions when executed further cause the one or more general purpose computing machines to perform: replacing the removed operators with one or more alternative operators incapable of invoking infinite loops.

1674. The one or more general purpose computing machines of aspect 1666 wherein the instructions when executed further cause the one or more general purpose computing machines to perform: replacing the removed operators with one or more alternative operators having unambiguous semantics.

1675. The one or more general purpose computing machines of aspect 1667 wherein the instructions when executed further cause the one or more general purpose computing machines to perform: replacing the removed operators with one or more alternative operators having unambiguous semantics.

1676. The one or more general purpose computing machines of aspect 1668 wherein the instructions when executed further cause the one or more general purpose computing machines to perform: replacing the removed operators with one or more alternative operators having unambiguous semantics.

1677. The one or more general purpose computing machines of aspect 1669 wherein the instructions when executed further cause the one or more general purpose computing machines to perform: replacing the removed operators with one or more alternative operators having unambiguous semantics.

1678. The one or more general purpose computing machines of aspect 1666 wherein the instructions cause the one or more general purpose computing machines to replace a for loop operator with “sum” operator.

1679. The one or more general purpose computing machines of aspect 1667 wherein the instructions cause the one or more general purpose computing machines to replace a for loop operator with “sum” operator.

1680. The one or more general purpose computing machines of aspect 1668 wherein the instructions cause the one or more general purpose computing machines to replace a for loop operator with “sum” operator.

1681. The one or more general purpose computing machines of aspect 1669 wherein the instructions cause the one or more general purpose computing machines to replace a for loop operator with “sum” operator.

1682. The one or more general purpose computing machines of aspect 1670 wherein the instructions cause the one or more general purpose computing machines to replace a for loop operator with “sum” operator.

1683. The one or more general purpose computing machines of aspect 1671 wherein the instructions cause the one or more general purpose computing machines to replace a for loop operator with “sum” operator.

1684. The one or more general purpose computing machines of aspect 1672 wherein the instructions cause the one or more general purpose computing machines to replace a for loop operator with “sum” operator.

1685. The one or more general purpose computing machines of aspect 1673 wherein the instructions cause the one or more general purpose computing machines to replace a for loop operator with “sum” operator.

1686. The one or more general purpose computing machines of aspect 1674 wherein the instructions cause the one or more general purpose computing machines to replace a for loop operator with “sum” operator.

1687. The one or more general purpose computing machines of aspect 1675 wherein the instructions cause the one or more general purpose computing machines to replace a for loop operator with “sum” operator.

1688. The one or more general purpose computing machines of aspect 1676 wherein the instructions cause the one or more general purpose computing machines to replace a for loop operator with “sum” operator.

1689. The one or more general purpose computing machines of aspect 1677 wherein the instructions cause the one or more general purpose computing machines to replace a for loop operator with “sum” operator.

1690. The one or more general purpose computing machines of aspect 1664, wherein instructions for modifying the language include instructions for redefining one or more data types.

1691. The one or more general purpose computing machines of aspect 1664, wherein instructions for modifying the language include instructions for replacing one or more data types.

1692. The one or more general purpose computing machines of aspect 1665, wherein instructions for modifying the language include instructions for redefining one or more data types.

1693. The one or more general purpose computing machines of aspect 1665, wherein instructions for modifying the language include instructions for replacing one or more data types.

1694. The one or more general purpose computing machines of aspect 1666, wherein instructions for modifying the language include instructions for redefining one or more data types.

1695. The one or more general purpose computing machines of aspect 1666, wherein instructions for modifying the language include instructions for replacing one or more data types.

1696. The one or more general purpose computing machines of aspect 1667, wherein instructions for modifying the language include instructions for redefining one or more data types.

1697. The one or more general purpose computing machines of aspect 1667, wherein instructions for modifying the language include instructions for replacing one or more data types.

1698. The one or more general purpose computing machines of aspect 1668, wherein instructions for modifying the language include instructions for redefining one or more data types.

1699. The one or more general purpose computing machines of aspect 1668, wherein instructions for modifying the language include instructions for replacing one or more data types.

1700. The one or more general purpose computing machines of aspect 1669, wherein instructions for modifying the language include instructions for redefining one or more data types.

1701. The one or more general purpose computing machines of aspect 1669, wherein instructions for modifying the language include instructions for replacing one or more data types.

1702. The one or more general purpose computing machines of aspect 1670, wherein instructions for modifying the language include instructions for redefining one or more data types.

1703. The one or more general purpose computing machines of aspect 1670, wherein instructions for modifying the language include instructions for replacing one or more data types.

1704. The one or more general purpose computing machines of aspect 1671, wherein instructions for modifying the language include instructions for redefining one or more data types.

1705. The one or more general purpose computing machines of aspect 1671, wherein instructions for modifying the language include instructions for replacing one or more data types.

1706. The one or more general purpose computing machines of aspect 1672, wherein instructions for modifying the language include instructions for redefining one or more data types.

1707. The one or more general purpose computing machines of aspect 1672, wherein instructions for modifying the language include instructions for replacing one or more data types.

1708. The one or more general purpose computing machines of aspect 1673, wherein instructions for modifying the language include instructions for redefining one or more data types.

1709. The one or more general purpose computing machines of aspect 1673, wherein instructions for modifying the language include instructions for replacing one or more data types.

1710. The one or more general purpose computing machines of aspect 1674, wherein instructions for modifying the language include instructions for redefining one or more data types.

1711. The one or more general purpose computing machines of aspect 1674, wherein instructions for modifying the language include instructions for replacing one or more data types.

1712. The one or more general purpose computing machines of aspect 1675, wherein instructions for modifying the language include instructions for redefining one or more data types.

1713. The one or more general purpose computing machines of aspect 1675, wherein instructions for modifying the language include instructions for replacing one or more data types.

1714. The one or more general purpose computing machines of aspect 1676, wherein instructions for modifying the language include instructions for redefining one or more data types.

1715. The one or more general purpose computing machines of aspect 1676, wherein instructions for modifying the language include instructions for replacing one or more data types.

1716. The one or more general purpose computing machines of aspect 1677, wherein instructions for modifying the language include instructions for redefining one or more data types.

1717. The one or more general purpose computing machines of aspect 1677, wherein instructions for modifying the language include instructions for replacing one or more data types.

1718. The one or more general purpose computing machines of aspect 1678, wherein instructions for modifying the language include instructions for redefining one or more data types.

1719. The one or more general purpose computing machines of aspect 1678, wherein instructions for modifying the language include instructions for replacing one or more data types.

1720. The one or more general purpose computing machines of aspect 1679, wherein instructions for modifying the language include instructions for redefining one or more data types.

1721. The one or more general purpose computing machines of aspect 1679, wherein instructions for modifying the language include instructions for replacing one or more data types.

1722. The one or more general purpose computing machines of aspect 1680, wherein instructions for modifying the language include instructions for redefining one or more data types.

1723. The one or more general purpose computing machines of aspect 1680, wherein instructions for modifying the language include instructions for replacing one or more data types.

1724. The one or more general purpose computing machines of aspect 1681, wherein instructions for modifying the language include instructions for redefining one or more data types.

1725. The one or more general purpose computing machines of aspect 1681, wherein instructions for modifying the language include instructions for replacing one or more data types.

1726. The one or more general purpose computing machines of aspect 1682, wherein instructions for modifying the language include instructions for redefining one or more data types.

1727. The one or more general purpose computing machines of aspect 1682, wherein instructions for modifying the language include instructions for replacing one or more data types.

1728. The one or more general purpose computing machines of aspect 1683, wherein instructions for modifying the language include instructions for redefining one or more data types.

1729. The one or more general purpose computing machines of aspect 1683, wherein instructions for modifying the language include instructions for replacing one or more data types.

1730. The one or more general purpose computing machines of aspect 1684, wherein instructions for modifying the language include instructions for redefining one or more data types.

1731. The one or more general purpose computing machines of aspect 1684, wherein instructions for modifying the language include instructions for replacing one or more data types.

1732. The one or more general purpose computing machines of aspect 1685, wherein instructions for the language include instructions for redefining one or more data types.

1733. The one or more general purpose computing machines of aspect 1685, wherein instructions for the language include instructions for replacing one or more data types.

1734. The one or more general purpose computing machines of aspect 1686, wherein instructions for modifying the language include instructions for redefining one or more data types.

1735. The one or more general purpose computing machines of aspect 1686, wherein instructions for modifying the language include instructions for replacing one or more data types.

1736. The one or more general purpose computing machines of aspect 1687, wherein instructions for modifying the language include instructions for redefining one or more data types.

1737. The one or more general purpose computing machines of aspect 1687, wherein instructions for modifying the language include instructions for replacing one or more data types.

1738. The one or more general purpose computing machines of aspect 1688, wherein instructions for modifying the language include instructions for redefining one or more data types.

1739. The one or more general purpose computing machines of aspect 1688, wherein instructions for modifying the language include instructions for replacing one or more data types.

1740. The one or more general purpose computing machines of aspect 1689, wherein instructions for modifying the language include instructions for redefining one or more data types.

1741. The one or more general purpose computing machines of aspect 1689, wherein instructions for modifying the language include instructions for replacing one or more data types.

1742. The one or more general purpose computing machines of aspect 1664 wherein the instructions when executed further cause the one or more general purpose computing machines to perform: verifying that all programs created in the language have decidable and complete data flow.

1743. One or more general purpose computing machines collectively comprising (i) one or more storage devices having one or more sets of instructions stored thereon and (ii) one or more processors adapted to execute the one or more sets of instructions, wherein the execution of the one or more sets of instructions includes:
specifying a known programming language; and
modifying the language wherein the modified language satisfies both a finite code path property and a data flow property.

1744. The one or more general purpose computing machines of aspect 1743 wherein the instructions when executed further cause the one or more general purpose computing machines to perform verifying compliance with the finite code path property.

1745. The one or more general purpose computing machines of aspect 1743 wherein the instructions when executed further cause the one or more general purpose computing machines to perform verifying compliance with the data flow property.

1746. The one or more general purpose computing machines of aspect 1744 wherein the instructions when executed further cause the one or more general purpose computing machines to perform verifying compliance with the data flow property.

1747. The one or more general purpose computing machines of aspect 1743 wherein said modifying the language includes redefining one or more data types.

1748. The one or more general purpose computing machines of aspect 1744 wherein said modifying the language includes redefining one or more data types.

1749. The one or more general purpose computing machines of aspect 1745 wherein said modifying the language includes redefining one or more data types.

1750. The one or more general purpose computing machines of aspect 1746 wherein said modifying the language includes redefining one or more data types.

1751. The one or more general purpose computing machines of aspect 1743 wherein said modifying the language includes replacing one or more operators having ambiguous semantics with replacement operators having unambiguous semantics.

1752. The one or more general purpose computing machines of aspect 1744 wherein said modifying the language includes replacing one or more operators having ambiguous semantics with replacement operators having unambiguous semantics.

1753. The one or more general purpose computing machines of aspect 1745 wherein said modifying the language includes replacing one or more operators having ambiguous semantics with replacement operators having unambiguous semantics.

1754. The one or more general purpose computing machines of aspect 1746 wherein said modifying the language includes replacing one or more operators having ambiguous semantics with replacement operators having unambiguous semantics.

1755. The one or more general purpose computing machines of aspect 1747 wherein said modifying the language includes replacing one or more operators having ambiguous semantics with replacement operators having unambiguous semantics.

1756. The one or more general purpose computing machines of aspect 1748 wherein said modifying the language includes replacing one or more operators having ambiguous semantics with replacement operators having unambiguous semantics.

1757. The one or more general purpose computing machines of aspect 1749 wherein said modifying the language includes replacing one or more operators having ambiguous semantics with replacement operators having unambiguous semantics.

1758. The one or more general purpose computing machines of aspect 1750 wherein said modifying the language includes replacing one or more operators having ambiguous semantics with replacement operators having unambiguous semantics.

1759. The one or more general purpose computing machines of aspect 1747 wherein the redefined data types comprise enumerable and non-enumerable data types.

1760. The one or more general purpose computing machines of aspect 1748 wherein the redefined data types comprise enumerable and non-enumerable data types.

1761. The one or more general purpose computing machines of aspect 1749 wherein the redefined data types comprise enumerable and non-enumerable data types.

1762. The one or more general purpose computing machines of aspect 1750 wherein the redefined data types comprise enumerable and non-enumerable data types.

1763. The one or more general purpose computing machines of aspect 1747 wherein the redefined data types comprise enumerable and non-enumerable data types.

1764. The one or more general purpose computing machines of aspect 1759 wherein all data elements of the non-enumerated data types are represented as sets.

1765. The one or more general purpose computing machines of aspect 1760 wherein all data elements of the non-enumerated data types are represented as sets.

1766. The one or more general purpose computing machines of aspect 1761 wherein all data elements of the non-enumerated data types are represented as sets.

1767. The one or more general purpose computing machines of aspect 1762 wherein all data elements of the non-enumerated data types are represented as sets.

1768. The one or more general purpose computing machines of aspect 1763 wherein all data elements of the non-enumerated data types are represented as sets.

1769. The one or more general purpose computing machines of aspect 1764 wherein all data elements consisting of infinite sets are expressed with a finite lexical notation.

1770. The one or more general purpose computing machines of aspect 1765 wherein all data elements consisting of infinite sets are expressed with a finite lexical notation.

1771. The one or more general purpose computing machines of aspect 1766 wherein all data elements consisting of infinite sets are expressed with a finite lexical notation.

1772. The one or more general purpose computing machines of aspect 1767 wherein all data elements consisting of infinite sets are expressed with a finite lexical notation.

1773. The one or more general purpose computing machines of aspect 1768 wherein all data elements consisting of infinite sets are expressed with a finite lexical notation.

1774. The one or more general purpose computing machines of aspect 1764 wherein numeric data types are non-enumerated data types and numeric data elements of the numeric data types are expressed using equalities and/or inequalities.

1775. The one or more general purpose computing machines of aspect 1765 wherein numeric data types are non-enumerated data types and numeric data elements of the numeric data types are expressed using equalities and/or inequalities.

1776. The one or more general purpose computing machines of aspect 1766 wherein numeric data types are non-enumerated data types and numeric data elements of the numeric data types are expressed using equalities and/or inequalities.

1777. The one or more general purpose computing machines of aspect 1767 wherein numeric data types are non-enumerated data types and numeric data elements of the numeric data types are expressed using equalities and/or inequalities.

1778. The one or more general purpose computing machines of aspect 1768 wherein numeric data types are non-enumerated data types and numeric data elements of the numeric data types are expressed using equalities and/or inequalities.

1779. The one or more general purpose computing machines of aspect 1744 wherein said verifying compliance with the finite code path property includes demonstrating all possible code paths within the language can be expressed in a finite tree model.

1780. The one or more general purpose computing machines of aspect 1779, wherein the tree model comprises a directed acyclic graph.

1781. The one or more general purpose computing machines of aspect 1780 wherein said demonstrating all possible code paths within the language includes generating a tree model using a tableau algorithm.

1782. The one or more general purpose computing machines of aspect 1779 wherein said demonstrating all possible code paths within the language includes generating a tree model using a tableau algorithm.

1783. The one or more general purpose computing machines of aspect 1779 wherein said demonstrating all possible code paths within the language includes generating a tree model using a model search algorithm.

1784. The one or more general purpose computing machines of aspect 1745 wherein said further comprising verifying compliance with the finite code path property includes demonstrating all possible code paths within the language can be expressed in a finite tree model.

1785. The one or more general purpose computing machines of aspect 1784, wherein the tree model comprises a directed acyclic graph.

1786. The one or more general purpose computing machines of aspect 1785 wherein said demonstrating all possible code paths within the language includes generating a tree model using a tableau algorithm.

1787. The one or more general purpose computing machines of aspect 1757 wherein said demonstrating all possible code paths within the language includes generating a tree model using a tableau algorithm.

1788. The one or more general purpose computing machines of aspect 1757 wherein said demonstrating all possible code paths within the language includes generating a tree model using a model search algorithm.

1789. The one or more general purpose computing machines of aspect 1746 wherein said further comprising verifying compliance with the finite code path property includes demonstrating all possible code paths within the language can be expressed in a finite tree model.

1790. The one or more general purpose computing machines of aspect 1789, wherein the tree model comprises a directed acyclic graph.

1791. The one or more general purpose computing machines of aspect 1790 wherein said demonstrating all possible code paths within the language includes generating a tree model using a tableau algorithm.

1792. The one or more general purpose computing machines of aspect 1789 wherein said demonstrating all possible code paths within the language includes generating a tree model using a tableau algorithm.

1793. The one or more general purpose computing machines of aspect 1789 wherein said demonstrating all possible code paths within the language includes generating a tree model using a model search algorithm.

1794. The one or more general purpose computing machines of aspect 1745, wherein said verifying compliance with the data flow property includes identifying a set of one or more complete and correct algorithms that can determine the value of any data element in the set of all programs written in the language.

1795. The one or more general purpose computing machines of aspect 1794 wherein said identifying a set of one or more complete and correct algorithms includes demonstrating a valid algorithm for each data type associated with the language.

1796. The one or more general purpose computing machines of aspect 1795, wherein said demonstrating a valid algorithm for each data type includes utilizing automated algebraic analysis.

1797. The one or more general purpose computing machines of aspect 1795, wherein said demonstrating a valid algorithm for each data type includes utilizing approximation.

1798. The one or more general purpose computing machines of aspect 1749, wherein said verifying compliance with the data flow property includes identifying a set of one or more complete and correct algorithms that can determine the value of any data element in the set of all programs written in the language.

1799. The one or more general purpose computing machines of aspect 1798 wherein said identifying a set of one or more complete and correct algorithms includes demonstrating a valid algorithm for each data type associated with the language.

1800. The one or more general purpose computing machines of aspect 1799, wherein said demonstrating a valid algorithm for each data type includes utilizing automated algebraic analysis.

1801. The one or more general purpose computing machines of aspect 1799, wherein said demonstrating a valid algorithm for each data type includes utilizing approximation.

1802. The one or more general purpose computing machines of aspect 1753, wherein said verifying compliance with the data flow property includes identifying a set of one or more complete and correct algorithms that can determine the value of any data element in the set of all programs written in the language.

1803. The one or more general purpose computing machines of aspect 1802 wherein said identifying a set of one or more complete and correct algorithms includes demonstrating a valid algorithm for each data type associated with the language.

1804. The one or more general purpose computing machines of aspect 1803, wherein said demonstrating a valid algorithm for each data type includes utilizing automated algebraic analysis.

1805. The one or more general purpose computing machines of aspect 1803, wherein said demonstrating a valid algorithm for each data type includes utilizing approximation.

1806. The one or more general purpose computing machines of aspect 1744, further comprising instructions that, when executed by one or more general purpose computing machines, cause the one or more general purpose computing machines to perform the following: repeating modifying the language after said verifying compliance with the finite code path property if compliance with the finite code path property is unverifiable.

1807. The one or more general purpose computing machines of aspect 1806, wherein the operations of modifying and verifying are repeated iteratively until the finite code path property is verified.

1808. The one or more general purpose computing machines of aspect 1746, further comprising instructions that, when executed by one or more general purpose computing machines, cause the one or more general purpose computing machines to perform the following: repeating modifying the language after said verifying compliance with the finite code path property if compliance with the finite code path property is unverifiable.

1809. The one or more general purpose computing machines of aspect 1808, wherein the operations of modifying and verifying are repeated iteratively until the finite code path property is verified.

1810. The one or more general purpose computing machines of aspect 1748, further comprising instructions that, when executed by one or more general purpose computing machines, cause the one or more general purpose computing machines to perform the following: repeating modifying the language after said verifying compliance with the finite code path property if compliance with the finite code path property is unverifiable.

1811. The one or more general purpose computing machines of aspect 1810, wherein the operations of modifying and verifying are repeated iteratively until the finite code path property is verified.

1812. The one or more general purpose computing machines of aspect 1750, further comprising instructions that, when executed by one or more general purpose computing machines, cause the one or more general purpose computing machines to perform the following: repeating modifying the language after said verifying compliance with the finite code path property if compliance with the finite code path property is unverifiable.

1813. The one or more general purpose computing machines of aspect 1812, wherein the operations of modifying and verifying are repeated iteratively until the finite code path property is verified.

1814. The one or more general purpose computing machines of aspect 1752, further comprising instructions that, when executed by one or more general purpose computing machines, cause the one or more general purpose computing machines to perform the following: repeating modifying the language after said verifying compliance with the finite code path property if compliance with the finite code path property is unverifiable.

1815. The one or more general purpose computing machines of aspect 1814, wherein the operations of modifying and verifying are repeated iteratively until the finite code path property is verified.

1816. The one or more general purpose computing machines of aspect 1756, further comprising instructions that, when executed by one or more general purpose computing machines, cause the one or more general purpose computing machines to perform the following: repeating modifying the language after said verifying compliance with the finite code path property if compliance with the finite code path property is unverifiable.

1817. The one or more general purpose computing machines of aspect 1816, wherein the operations of modifying and verifying are repeated iteratively until the finite code path property is verified.

1818. The one or more general purpose computing machines of aspect 1758, further comprising instructions that, when executed by one or more general purpose computing machines, cause the one or more general purpose computing machines to perform the following: repeating modifying the language after said verifying compliance with the finite code path property if compliance with the finite code path property is unverifiable.

1819. The one or more general purpose computing machines of aspect 1818, wherein the operations of modifying and verifying are repeated iteratively until the finite code path property is verified.

1820. The one or more general purpose computing machines of aspect 1760, further comprising instructions that, when executed by one or more general purpose computing machines, cause the one or more general purpose computing machines to perform the following: repeating modifying the language after said verifying compliance with the finite code path property if compliance with the finite code path property is unverifiable.

1821. The one or more general purpose computing machines of aspect 1820, wherein the operations of modifying and verifying are repeated iteratively until the finite code path property is verified.

1822. The one or more general purpose computing machines of aspect 1762, further comprising instructions that, when executed by one or more general purpose computing machines, cause the one or more general purpose computing machines to perform the following: repeating modifying the language after said verifying compliance with the finite code path property if compliance with the finite code path property is unverifiable.

1823. The one or more general purpose computing machines of aspect 1822, wherein the operations of modifying and verifying are repeated iteratively until the finite code path property is verified.

1824. The one or more general purpose computing machines of aspect 1765, further comprising instructions that, when executed by one or more general purpose computing machines, cause the one or more general purpose computing machines to perform the following: repeating modifying the language after said verifying compliance with the finite code path property if compliance with the finite code path property is unverifiable.

1825. The one or more general purpose computing machines of aspect 1824, wherein the operations of modifying and verifying are repeated iteratively until the finite code path property is verified.

1826. The one or more general purpose computing machines of aspect 1767, further comprising instructions that, when executed by one or more general purpose computing machines, cause the one or more general purpose computing machines to perform the following: repeating modifying the language after said verifying compliance with the finite code path property if compliance with the finite code path property is unverifiable.

1827. The one or more general purpose computing machines of aspect 1826, wherein the operations of modifying and verifying are repeated iteratively until the finite code path property is verified.

1828. The one or more general purpose computing machines of aspect 1770, further comprising instructions that, when executed by one or more general purpose computing machines, cause the one or more general purpose computing machines to perform the following: repeating modifying the language after said verifying compliance with the finite code path property if compliance with the finite code path property is unverifiable.

1829. The one or more general purpose computing machines of aspect 1828, wherein the operations of modifying and verifying are repeated iteratively until the finite code path property is verified.

1830. The one or more general purpose computing machines of aspect 1772, further comprising instructions that, when executed by one or more general purpose computing machines, cause the one or more general purpose computing machines to perform the following: repeating modifying the language after said verifying compliance with the finite code path property if compliance with the finite code path property is unverifiable.

1831. The one or more general purpose computing machines of aspect 1830, wherein the operations of modifying and verifying are repeated iteratively until the finite code path property is verified.

1832. The one or more general purpose computing machines of aspect 1775, further comprising instructions that, when executed by one or more general purpose computing machines, cause the one or more general purpose computing machines to perform the following: repeating modifying the language after said verifying compliance with the finite code path property if compliance with the finite code path property is unverifiable.

1833. The one or more general purpose computing machines of aspect 1832, wherein the operations of modifying and verifying are repeated iteratively until the finite code path property is verified.

1834. The one or more general purpose computing machines of aspect 1777, further comprising instructions that, when executed by one or more general purpose computing machines, cause the one or more general purpose computing machines to perform the following: repeating modifying the language after said verifying compliance with the finite code path property if compliance with the finite code path property is unverifiable.

1835. The one or more general purpose computing machines of aspect 1834, wherein the operations of modifying and verifying are repeated iteratively until the finite code path property is verified.

1836. The one or more general purpose computing machines of aspect 1779, further comprising instructions that, when executed by one or more general purpose computing machines, cause the one or more general purpose computing machines to perform the following: repeating modifying the language after said verifying compliance with the finite code path property if compliance with the finite code path property is unverifiable.

1837. The one or more general purpose computing machines of aspect 1836, wherein the operations of modifying and verifying are repeated iteratively until the finite code path property is verified.

1838. The one or more general purpose computing machines of aspect 1780, further comprising instructions that, when executed by one or more general purpose computing machines, cause the one or more general purpose computing machines to perform the following: repeating modifying the language after said verifying compliance with the finite code path property if compliance with the finite code path property is unverifiable.

1839. The one or more general purpose computing machines of aspect 1838, wherein the operations of modifying and verifying are repeated iteratively until the finite code path property is verified.

1840. The one or more general purpose computing machines of aspect 1781, further comprising instructions that, when executed by one or more general purpose computing machines, cause the one or more general purpose computing machines to perform the following: repeating modifying the language after said verifying compliance with the finite code path property if compliance with the finite code path property is unverifiable.

1841. The one or more general purpose computing machines of aspect 1840, wherein the operations of modifying and verifying are repeated iteratively until the finite code path property is verified.

1842. The one or more general purpose computing machines of aspect 1782, further comprising instructions that, when executed by one or more general purpose computing machines, cause the one or more general purpose computing machines to perform the following: repeating modifying the language after said verifying compliance with the finite code path property if compliance with the finite code path property is unverifiable.

1843. The one or more general purpose computing machines of aspect 1842, wherein the operations of modifying and verifying are repeated iteratively until the finite code path property is verified.

1844. The one or more general purpose computing machines of aspect 1783, further comprising instructions that, when executed by one or more general purpose computing machines, cause the one or more general purpose computing machines to perform the following: repeating modifying the language after said verifying compliance with the finite code path property if compliance with the finite code path property is unverifiable.

1845. The one or more general purpose computing machines of aspect 1844, wherein the operations of modifying and verifying are repeated iteratively until the finite code path property is verified.

1846. The one or more general purpose computing machines of aspect 1789, further comprising instructions that, when executed by one or more general purpose computing machines, cause the one or more general purpose computing machines to perform the following: repeating modifying the language after said verifying compliance with the finite code path property if compliance with the finite code path property is unverifiable.

1847. The one or more general purpose computing machines of aspect 1846, wherein the operations of modifying and verifying are repeated iteratively until the finite code path property is verified.

1848. The one or more general purpose computing machines of aspect 1792, further comprising instructions that, when executed by one or more general purpose computing machines, cause the one or more general purpose computing machines to perform the following: repeating modifying the language after said verifying compliance with the finite code path property if compliance with the finite code path property is unverifiable.

1849. The one or more general purpose computing machines of aspect 1848, wherein the operations of modifying and verifying are repeated iteratively until the finite code path property is verified.

1850. The one or more general purpose computing machines of aspect 1793, further comprising instructions that, when executed by one or more general purpose computing machines, cause the one or more general purpose computing machines to perform the following: repeating modifying the language after said verifying compliance with the finite code path property if compliance with the finite code path property is unverifiable.

1851. The one or more general purpose computing machines of aspect 1850, wherein the operations of modifying and verifying are repeated iteratively until the finite code path property is verified.

1852. A general purpose computing machine comprising (i) a storage device including one or more sets of instructions stored thereon and (ii) a processor adapted to execute the one or more sets of instructions, wherein the execution of the one or more sets of instructions includes:
generating a parse tree;
generating a code path set based on the parse tree;
generating a path data model set using the code path set; and
generating a finite input/output semantic model (FIOSM) from the path data model set.

1853. The general purpose computing machine of aspect 1852, wherein the generation of a finite input/output semantic model dictates that the software has a completely decidable data flow.

1854. The general purpose computing machine of aspect 1852 wherein said generating a parse tree comprises parsing the source code of a software procedure.

1855. The general purpose computing machine of aspect 1852 wherein said generating a parse tree comprises parsing the source code of a software program.

1856. The general purpose computing machine of aspect 1852 wherein the parse tree comprises a directed acyclic graph structure (DAG).

1857. The general purpose computing machine of aspect 1854, wherein the source code is written in a FIOSM compliant programming language.

1858. The general purpose computing machine of aspect 1855, wherein the source code is written in a FIOSM compliant programming language.

1859. The general purpose computing machine of aspect 1852, wherein said generating a code path set based on the parse tree comprises utilizing a suitable algorithm to walk the parse tree.

1860. The general purpose computing machine of aspect 1852, wherein the code path set comprises condition free code path trees.

1861. The general purpose computing machine of aspect 1859, wherein the suitable algorithm comprises a tableau algorithm.

1862. The general purpose computing machine of aspect 1859, wherein the suitable algorithm comprises a book-marking algorithm.

1863. The general purpose computing machine of aspect 1852, wherein the path data model set comprises a plurality of logically consistent data element models.

1864. The general purpose computing machine of aspect 1863, wherein said generating a path data model set using the code path set includes discarding any logically inconsistent data element models.

1865. The general purpose computing machine of aspect 1852, wherein said generating a path data model set using the code path set comprises for each code path set element: (i) walking the code path parse tree of the code path set element; (ii) recording assignments and constraints for the code path set element.

1866. The general purpose computing machine of aspect 1852, wherein said generating a path data model set using the code path set comprises converting the code path set into a set of logically consistent data model elements.

1867. The general purpose computing machine of aspect 1852, wherein said generating a finite input/output semantic model (FIOSM) from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

1868. The general purpose computing machine of aspect 1867, wherein said formatting a FIOSM from the path data model set further comprises: eliminating intermediate data elements.

1869. A general purpose computing machine comprising (i) a storage device including one or more sets of instructions stored thereon and (ii) a processor adapted to execute the one or more sets of instructions, wherein the execution of the one or more sets of instructions includes generating a finite input output model (FIOSM) for a predetermined software program written in an FIOSM-compliant language.

1870. The general purpose computing machine of aspect 1869, wherein the sets of instructions further cause the general purpose computing machine to create a FIOSM compliant language.

1871. The general purpose computing machine of aspect 1869, wherein the sets of instructions further cause the general purpose computing machine to modify an existing computer language to be an FIOSM compliant language.

1872. The general purpose computing machine of aspect 1869, wherein the sets of instructions further cause the general purpose computing machine to modify an existing non-FIOSM compliant computer language to be an FIOSM compliant language.

1873. The general purpose computing machine of aspect 1869, wherein wherein the sets of instructions further cause the general purpose computing machine to generate a FIOSM further causes the general purpose computing machine to:
parse the source code of the program to generate a parse tree;
generate a code path set using the parse tree;
generate a path data model set using the code path set; and
format a FIOSM from the path data model set.

1874. The general purpose computing machine of aspect 1869, wherein the FIOSM consists of all possible inputs to the software program and all possible outputs the software program can generate based on all possible inputs.

1875. The general purpose computing machine of aspect 1874, wherein the parse tree comprises a directed acyclic graph structure (DAG).

1876. The general purpose computing machine of aspect 1873, wherein the parse tree comprises a directed acyclic graph structure (DAG).

1877. The general purpose computing machine of aspect 1873, wherein the parse tree comprises a tree model

1878. The general purpose computing machine of aspect 1873 wherein the instructions to generate code path sets using the parse tree utilize a suitable algorithm to walk the parse tree.

1879. The general purpose computing machine of aspect 1878 wherein the suitable algorithm comprises a tableau algorithm.

1880. The general purpose computing machine of aspect 1878 wherein the suitable algorithm comprises a model search algorithm.

1881. The general purpose computing machine of aspect 1873 wherein the path data model set comprises a plurality of logically consistent data element models.

1882. The general purpose computing machine of aspect 1878 wherein instructions to generate a path data model set using the code path set include instructions to discard any logically inconsistent data element models.

1883. The general purpose computing machine of aspect 1873 wherein the instructions to generate a path data model set using the code path sets further include for each code path set element instructions to: (i) walk the code path parse tree of the code path set element; (ii) record assignments and constraints for the code path set element.

1884. The general purpose computing machine of aspect 1873 wherein the instructions to format a FIOSM from the path data model set include instructions to: (i) identify a set of input data elements in the program; (ii) identify a set of output data elements; (iii) for each member of the path data model set, create a input-output pattern expression; (iv) for each input data element, generate an input data expression and adding it to an input set; and (v) for each output data element, generate an output data expression and adding it to an output set.

1885. The general purpose computing machine of aspect 1884, wherein the instructions to format a FIOSM from the path data model set further instructions to: eliminate intermediate data elements.

1886. A general purpose computing machine comprising (i) a storage device including one or more sets of instructions stored thereon and (ii) a processor adapted to execute the one or more sets of instructions, wherein the execution of the one or more sets of instructions includes: causing the general purpose computing machine toperform operations employing a finite input/output semantic model (FIOSM).

1887. The general purpose computing machine of aspect 1886 wherein said instructions employing a finite input/output semantic model further include instructions for designing a software programming language having decidable and complete dataflow wherein any and all software procedures created in the programming language can be represented by an FIOSM.

1888. The general purpose computing machine of aspect 1886 wherein said instructions employing a finite input/output semantic model further include instructions for modifying an existing software programming language wherein any and all software procedures created in the programming language can be represented by an FIOSM.

1889. The general purpose computing machine of aspect 1888 wherein the existing software language comprises one of C, C+, C++, Java, Basic, Pascal, and Fortran.

1890. The general purpose computing machine of aspect 1888, wherein said instructions for modifying an existing software programming language further include instructions for removing all operators (i) having ambiguous semantics and (ii) being capable of invoking infinite code paths.

1891. The general purpose computing machine of aspect 1888, wherein said instructions for modifying an existing software programming language further include instructions for removing all operators capable of invoking infinite code paths.

1892. The general purpose computing machine of aspect 1890 wherein the existing software language comprises one of C, C+, C++, Java, Basic, Pascal, and Fortran.

1893. The general purpose computing machine of aspect 1891 wherein the existing software language comprises one of C, C+, C++, Java, Basic, Pascal, and Fortran.

1894. The general purpose computing machine of aspect 1890 further including instructions for replacing the removed operators with one or more alternative operators incapable of invoking infinite loops.

1895. The general purpose computing machine of aspect 1891 further including instructions for replacing the removed operators with one or more alternative operators incapable of invoking infinite loops.

1896. The general purpose computing machine of aspect 1892 further including instructions for replacing the removed operators with one or more alternative operators incapable of invoking infinite loops.

1897. The general purpose computing machine of aspect 1893 further including instructions for replacing the removed operators with one or more alternative operators incapable of invoking infinite loops.

1898. The general purpose computing machine of aspect 1890 further including instructions for replacing the removed operators with one or more alternative operators having unambiguous semantics.

1899. The general purpose computing machine of aspect 1891 further including instructions for replacing the removed operators with one or more alternative operators having unambiguous semantics.

1900. The general purpose computing machine of aspect 1892 further including instructions for replacing the removed operators with one or more alternative operators having unambiguous semantics.

1901. The general purpose computing machine of aspect 1893 further including instructions for replacing the removed operators with one or more alternative operators having unambiguous semantics.

1902. The general purpose computing machine of aspect 1890 wherein the instructions cause, when executed, a for loop operator to be replaced with “sum” operator.

1903. The general purpose computing machine of aspect 1891 wherein the instructions cause, when executed, a for loop operator to be replaced with “sum” operator.

1904. The general purpose computing machine of aspect 1892 wherein the instructions cause, when executed, a for loop operator to be replaced with “sum” operator.

1905. The general purpose computing machine of aspect 1893 wherein the instructions cause, when executed, a for loop operator to be replaced with “sum” operator.

1906. The general purpose computing machine of aspect 1888, wherein said instructions for modifying an existing software programming language includes instructions for redefining one or more data types.

1907. The general purpose computing machine of aspect 1888, wherein said instructions for modifying an existing software programming language include instructions for replacing one or more data types.

1908. The general purpose computing machine of aspect 1889, wherein said instructions for modifying an existing software programming language includes instructions for redefining one or more data types.

1909. The general purpose computing machine of aspect 1889, wherein said instructions for modifying an existing software programming language include instructions for replacing one or more data types.

1910. The general purpose computing machine of aspect 1890, wherein said instructions for modifying an existing software programming language includes instructions for redefining one or more data types.

1911. The general purpose computing machine of aspect 1890, wherein said instructions for modifying an existing software programming language include instructions for replacing one or more data types.

1912. The general purpose computing machine of aspect 1891, wherein said instructions for modifying an existing software programming language includes instructions for redefining one or more data types.

1913. The general purpose computing machine of aspect 1891, wherein said instructions for modifying an existing software programming language include instructions for replacing one or more data types.

1914. The general purpose computing machine of aspect 1892, wherein said instructions for modifying an existing software programming language includes instructions for redefining one or more data types.

1915. The general purpose computing machine of aspect 1892, wherein said instructions for modifying an existing software programming language include instructions for replacing one or more data types.

1916. The general purpose computing machine of aspect 1893, wherein said instructions for modifying an existing software programming language includes instructions for redefining one or more data types.

1917. The general purpose computing machine of aspect 1893, wherein said instructions for modifying an existing software programming language include instructions for replacing one or more data types.

1918. The general purpose computing machine of aspect 1894, wherein said instructions for modifying an existing software programming language includes instructions for redefining one or more data types.

1919. The general purpose computing machine of aspect 1894, wherein said instructions for modifying an existing software programming language include instructions for replacing one or more data types.

1920. The general purpose computing machine of aspect 1895, wherein said instructions for modifying an existing software programming language includes instructions for redefining one or more data types.

1921. The general purpose computing machine of aspect 1895, wherein said instructions for modifying an existing software programming language include instructions for replacing one or more data types.

1922. The general purpose computing machine of aspect 1896, wherein said instructions for modifying an existing software programming language includes instructions for redefining one or more data types.

1923. The general purpose computing machine of aspect 1896, wherein said instructions for modifying an existing software programming language include instructions for replacing one or more data types.

1924. The general purpose computing machine of aspect 1897, wherein said instructions for modifying an existing software programming language includes instructions for redefining one or more data types.

1925. The general purpose computing machine of aspect 1897, wherein said instructions for modifying an existing software programming language include instructions for replacing one or more data types.

1926. The general purpose computing machine of aspect 1898, wherein said instructions for modifying an existing software programming language includes instructions for redefining one or more data types.

1927. The general purpose computing machine of aspect 1898, wherein said instructions for modifying an existing software programming language include instructions for replacing one or more data types.

1928. The general purpose computing machine of aspect 1899, wherein said instructions for modifying an existing software programming language includes instructions for redefining one or more data types.

1929. The general purpose computing machine of aspect 1899, wherein said instructions for modifying an existing software programming language include instructions for replacing one or more data types.

1930. The general purpose computing machine of aspect 1900, wherein said instructions for modifying an existing software programming language includes instructions for redefining one or more data types.

1931. The general purpose computing machine of aspect 1900, wherein said instructions for modifying an existing software programming language include instructions for replacing one or more data types.

1932. The general purpose computing machine of aspect 1901, wherein said instructions for modifying an existing software programming language includes instructions for redefining one or more data types.

1933. The general purpose computing machine of aspect 1901, wherein said instructions for modifying an existing software programming language include instructions for replacing one or more data types.

1934. The general purpose computing machine of aspect 1887 wherein said instructions for designing a software programming language having decidable and complete dataflow include instructions for: (i) defining operators; and (ii) defining data types.

1935. The general purpose computing machine of aspect 1934 further including instructions stored thereon for: verifying the decidable and complete data flow.

1936. The general purpose computing machine of aspect 1934 wherein said instructions for defining operators include only specifying operators whose semantics are not ambiguous or cannot invoke infinite code paths.

1937. The general purpose computing machine of aspect 1935 wherein said instructions for defining operators includes only specifying operators whose semantics are not ambiguous or cannot invoke infinite code paths.

1938. The general purpose computing machine of aspect 1934 wherein the instructions when executed cause the one or more machine to represent the data types as enumerable and non-enumerable data types.

1939. The general purpose computing machine of aspect 1934 that when executed on the general purpose computing machine represent all data elements of the non-enumerated data types as sets.

1940. The general purpose computing machine of aspect 1939 wherein the instructions require that all data elements consisting of infinite sets are expressed with a finite lexical notation when executed on the general purpose computing machine.

1941. The general purpose computing machine of aspect 1939 that, when executed, cause the general purpose computing machine to represent numeric data types are non-enumerated data types and express numeric data elements of the numeric data types using equalities and/or inequalities.

1942. The general purpose computing machine of aspect 1935 wherein the instructions when executed cause the one or more machine to represent the data types as enumerable and non-enumerable data types.

1943. The general purpose computing machine of aspect 1935 that when executed on the general purpose computing machine represent all data elements of the non-enumerated data types as sets.

1944. The general purpose computing machine of aspect 1943 wherein the instructions require that all data elements consisting of infinite sets are expressed with a finite lexical notation when executed on the general purpose computing machine.

1945. The general purpose computing machine of aspect 1943 that, when executed, cause the general purpose computing machine to represent numeric data types are non-enumerated data types and express numeric data elements of the numeric data types using equalities and/or inequalities.

1946. The general purpose computing machine of aspect 1936 wherein the instructions when executed cause the one or more machine to represent the data types as enumerable and non-enumerable data types.

1947. The general purpose computing machine of aspect 1936 that when executed on the general purpose computing machine represent all data elements of the non-enumerated data types as sets.

1948. The general purpose computing machine of aspect 1947 wherein the instructions require that all data elements consisting of infinite sets are expressed with a finite lexical notation when executed on the general purpose computing machine.

1949. The general purpose computing machine of aspect 1947 that, when executed, cause the general purpose computing machine to represent numeric data types are non-enumerated data types and express numeric data elements of the numeric data types using equalities and/or inequalities.

1950. The general purpose computing machine of aspect 1937 wherein the instructions when executed cause the one or more machine to represent the data types as enumerable and non-enumerable data types.

1951. The general purpose computing machine of aspect 1937 that when executed on the general purpose computing machine represent all data elements of the non-enumerated data types as sets.

1952. The general purpose computing machine of aspect 1951 wherein the instructions require that all data elements consisting of infinite sets are expressed with a finite lexical notation when executed on the general purpose computing machine.

1953. The general purpose computing machine of aspect 1951 that, when executed, cause the general purpose computing machine to represent numeric data types are non-enumerated data types and express numeric data elements of the numeric data types using equalities and/or inequalities.

1954. The general purpose computing machine of aspect 1935 wherein said instructions for verifying decidable and complete data flow include instructions for verifying both a code path quality and a data flow quality of the language.

1955. The general purpose computing machine of aspect 1954 wherein said instructions for verifying a code path quality include instructions for demonstrating all possible code paths within the language can be expressed in a finite tree model.

1956. The general purpose computing machine of aspect 1955, wherein the tree model comprises a directed acyclic graph.

1957. The general purpose computing machine of aspect 1955, wherein said instructions for demonstrating all possible code paths within the language include instructions for generating a tree model using a tableau algorithm.

1958. The general purpose computing machine of aspect 1955, wherein said instructions for demonstrating all possible code paths within the language include instructions for generating a tree model using a model search algorithm.

1959. The general purpose computing machine of aspect 1954, wherein instructions for verifying the data flow quality further include instructions for identifying a set of one or more complete and correct algorithms that can determine the value of any data element in the set of all programs written in the language.

1960. The general purpose computing machine of aspect 1959 wherein instructions for identifying a set of one or more complete and correct algorithms include instructions for demonstrating a valid algorithm for each data type associated with the language.

1961. The general purpose computing machine of aspect 1960, wherein instructions for demonstrating a valid algorithm for each data type include instructions for utilizing automated algebraic analysis.

1962. The general purpose computing machine of aspect 1960, wherein instructions for demonstrating a valid algorithm for each data type include instructions for utilizing approximation.

1963. The general purpose computing machine of aspect 1935, further including instructions that when executed on the general purpose computing machine cause the machines to: repeat said designing the language after said verifying the decidable and complete data flow if decidable and complete data flow is unverifiable.

1964. The general purpose computing machine of aspect 1892, wherein the instructions for the operations of designing and verifying are executed by the general purpose computing machine repeatedly until decidable and complete data flow is verified.

1965. The general purpose computing machine of aspect 1886 wherein instructions for employing a finite input/output semantic model include instructions for generating a software procedure and a corresponding FIOSM for the software procedure.

1966. The general purpose computing machine of aspect 1886 wherein instructions for employing a finite input/output semantic model include instructions for generating a software routine and a corresponding FIOSM for the software routine.

1967. The general purpose computing machine of aspect 1886 wherein instructions for employing a finite input/output semantic model include instructions for generating a software program and a corresponding FIOSM for the software program.

1968. The general purpose computing machine of aspect 1886 wherein instructions for employing a finite input/output semantic model include instructions for generating a software module and a corresponding FIOSM for the software module.

1969. The general purpose computing machine of aspect 1886 wherein instructions for employing a finite input/output semantic model include instructions for generating a software enterprise system and a corresponding FIOSM for the software enterprise system.

1970. A general purpose computing machine comprising (i) a storage device including one or more sets of instructions for generating a finite input/output semantic model stored thereon and (ii) a processor adapted to execute the one or more sets of instructions, wherein the execution of the one or more sets of instructions includes:
receiving a source program;
parsing the source program into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the source program,
   identifying a set of output data elements in the source program, and for each set of data elements, creating an input-output pattern expression;
   producing a valid data expression for each set of input data elements; and
   producing a valid data expression for each set of output data elements.

1971. The general purpose computing machine of aspect 1970 wherein the abstract data structure comprises a parse tree.

1972. The general purpose computing machine of aspect 1970 wherein the abstract data structure comprises a tree model

1973. The general purpose computing machine of aspect 1970 wherein the abstract data structure comprises a directed acyclic graph structure.

1974. The general purpose computing machine of aspect 1971 wherein instructions for generating a set of code paths based on the abstract data structure include instructions for walking the parse tree.

1975. The general purpose computing machine of aspect 1971 wherein instructions for generating a set of code paths based on the abstract data structure include instructions for using a suitable algorithm to walk the parse tree.

1976. The general purpose computing machine of aspect 1975 wherein the suitable algorithm is a model-splitting type algorithm.

1977. The general purpose computing machine of aspect 1976 wherein the model-splitting type algorithm is a member of the Tableau family of algorithms.

1978. The general purpose computing machine of aspect 1975 wherein the suitable algorithm is a book-marking type algorithm.

1979. The general purpose computing machine of aspect 1975 wherein the suitable algorithm is a model search algorithm.

1980. The general purpose computing machine of aspect 1970 wherein each data element model of the set of logically consistent data element models represents one input-output pattern of the source program.

1981. The general purpose computing machine of aspect 1970, wherein instructions for converting the set of code paths into a set of logically consistent data element models include instructions for discarding logically inconsistent data element models from the set of code paths.

1982. The general purpose computing machine of aspect 1970, wherein instructions for converting the set of code paths into a set of logically consistent data element models include instructions for (i) walking the set of code paths, (ii) generating the set of data element models, and (iii) testing each data element model of the set for data-element consistency.

1983. A general purpose computing machine comprising (i) a storage device including one or more sets of instructions stored thereon and (ii) a processor adapted to execute the one or more sets of instructions, wherein the execution of the one or more sets of instructions includes:
specifying a known programming language; and
modifying the language wherein any program written in the language is finite input output semantic model compliant.

1984. The general purpose computing machine of aspect 1983 wherein the known programming language comprises one of: C, C+, C++, Java, Basic, Pascal, and Fortran.

1985. The general purpose computing machine of aspect 1983, wherein instructions for modifying language include instructions for removing all operators (i) having ambiguous semantics and (ii) being capable of invoking infinite code paths.

1986. The general purpose computing machine of aspect 1984, wherein instructions for modifying language include instructions for removing all operators (i) having ambiguous semantics and (ii) being capable of invoking infinite code paths.

1987. The general purpose computing machine of aspect 1983, wherein instructions for modifying an existing software programming language include instructions for removing all operators capable of invoking infinite code paths.

1988. The general purpose computing machine of aspect 1984, wherein instructions for modifying an existing software programming language include instructions for removing all operators capable of invoking infinite code paths.

1989. The general purpose computing machine of aspect 1985 wherein the instructions when executed further cause the general purpose computing machine to perform: replacing the removed operators with one or more alternative operators incapable of invoking infinite loops.

1990. The general purpose computing machine of aspect 1986 wherein the instructions when executed further cause the general purpose computing machine to perform: replacing the removed operators with one or more alternative operators incapable of invoking infinite loops.

1991. The general purpose computing machine of aspect 1987 wherein the instructions when executed further cause the general purpose computing machine to perform: replacing the removed operators with one or more alternative operators incapable of invoking infinite loops.

1992. The general purpose computing machine of aspect 1988 wherein the instructions when executed further cause the general purpose computing machine to perform: replacing the removed operators with one or more alternative operators incapable of invoking infinite loops.

1993. The general purpose computing machine of aspect 1985 wherein the instructions when executed further cause the general purpose computing machine to perform: replacing the removed operators with one or more alternative operators having unambiguous semantics.

1994. The general purpose computing machine of aspect 1986 wherein the instructions when executed further cause the general purpose computing machine to perform: replacing the removed operators with one or more alternative operators having unambiguous semantics.

1995. The general purpose computing machine of aspect 1987 wherein the instructions when executed further cause the general purpose computing machine to perform: replacing the removed operators with one or more alternative operators having unambiguous semantics.

1996. The general purpose computing machine of aspect 1988 wherein the instructions when executed further cause the general purpose computing machine to perform: replacing the removed operators with one or more alternative operators having unambiguous semantics.

1997. The general purpose computing machine of aspect 1985 wherein the instructions cause the general purpose computing machine to replace a for loop operator with “sum” operator.

1998. The general purpose computing machine of aspect 1986 wherein the instructions cause the general purpose computing machine to replace a for loop operator with “sum” operator.

1999. The general purpose computing machine of aspect 1987 wherein the instructions cause the general purpose computing machine to replace a for loop operator with “sum” operator.

2000. The general purpose computing machine of aspect 1988 wherein the instructions cause the general purpose computing machine to replace a for loop operator with “sum” operator.

2001. The general purpose computing machine of aspect 1989 wherein the instructions cause the general purpose computing machine to replace a for loop operator with “sum” operator.

2002. The general purpose computing machine of aspect 1990 wherein the instructions cause the general purpose computing machine to replace a for loop operator with “sum” operator.

2003. The general purpose computing machine of aspect 1991 wherein the instructions cause the general purpose computing machine to replace a for loop operator with “sum” operator.

2004. The general purpose computing machine of aspect 1992 wherein the instructions cause the general purpose computing machine to replace a for loop operator with “sum” operator.

2005. The general purpose computing machine of aspect 1993 wherein the instructions cause the general purpose computing machine to replace a for loop operator with “sum” operator.

2006. The general purpose computing machine of aspect 1994 wherein the instructions cause the general purpose computing machine to replace a for loop operator with “sum” operator.

2007. The general purpose computing machine of aspect 1995 wherein the instructions cause the general purpose computing machine to replace a for loop operator with “sum” operator.

2008. The general purpose computing machine of aspect 1996 wherein the instructions cause the general purpose computing machine to replace a for loop operator with “sum” operator.

2009. The general purpose computing machine of aspect 1983, wherein instructions for modifying the language include instructions for redefining one or more data types.

2010. The general purpose computing machine of aspect 1983, wherein instructions for modifying the language include instructions for replacing one or more data types.

2011. The general purpose computing machine of aspect 1984, wherein instructions for modifying the language include instructions for redefining one or more data types.

2012. The general purpose computing machine of aspect 1984, wherein instructions for modifying the language include instructions for replacing one or more data types.

2013. The general purpose computing machine of aspect 1985, wherein instructions for modifying the language include instructions for redefining one or more data types.

2014. The general purpose computing machine of aspect 1985, wherein instructions for modifying the language include instructions for replacing one or more data types.

2015. The general purpose computing machine of aspect 1986, wherein instructions for modifying the language include instructions for redefining one or more data types.

2016. The general purpose computing machine of aspect 1986, wherein instructions for modifying the language include instructions for replacing one or more data types.

2017. The general purpose computing machine of aspect 1987, wherein instructions for modifying the language include instructions for redefining one or more data types.

2018. The general purpose computing machine of aspect 1987, wherein instructions for modifying the language include instructions for replacing one or more data types.

2019. The general purpose computing machine of aspect 1988, wherein instructions for modifying the language include instructions for redefining one or more data types.

2020. The general purpose computing machine of aspect 1988, wherein instructions for modifying the language include instructions for replacing one or more data types.

2021. The general purpose computing machine of aspect 1989, wherein instructions for modifying the language include instructions for redefining one or more data types.

2022. The general purpose computing machine of aspect 1989, wherein instructions for modifying the language include instructions for replacing one or more data types.

2023. The general purpose computing machine of aspect 1990, wherein instructions for modifying the language include instructions for redefining one or more data types.

2024. The general purpose computing machine of aspect 1990, wherein instructions for modifying the language include instructions for replacing one or more data types.

2025. The general purpose computing machine of aspect 1991, wherein instructions for modifying the language include instructions for redefining one or more data types.

2026. The general purpose computing machine of aspect 1991, wherein instructions for modifying the language include instructions for replacing one or more data types.

2027. The general purpose computing machine of aspect 1992, wherein instructions for modifying the language include instructions for redefining one or more data types.

2028. The general purpose computing machine of aspect 1992, wherein instructions for modifying the language include instructions for replacing one or more data types.

2029. The general purpose computing machine of aspect 1993, wherein instructions for modifying the language include instructions for redefining one or more data types.

2030. The general purpose computing machine of aspect 1993, wherein instructions for modifying the language include instructions for replacing one or more data types.

2031. The general purpose computing machine of aspect 1994, wherein instructions for modifying the language include instructions for redefining one or more data types.

2032. The general purpose computing machine of aspect 1994, wherein instructions for modifying the language include instructions for replacing one or more data types.

2033. The general purpose computing machine of aspect 1995, wherein instructions for modifying the language include instructions for redefining one or more data types.

2034. The general purpose computing machine of aspect 1995, wherein instructions for modifying the language include instructions for replacing one or more data types.

2035. The general purpose computing machine of aspect 1996, wherein instructions for modifying the language include instructions for redefining one or more data types.

2036. The general purpose computing machine of aspect 1996, wherein instructions for modifying the language include instructions for replacing one or more data types.

2037. The general purpose computing machine of aspect 1997, wherein instructions for modifying the language include instructions for redefining one or more data types.

2038. The general purpose computing machine of aspect 1997, wherein instructions for modifying the language include instructions for replacing one or more data types.

2039. The general purpose computing machine of aspect 1998, wherein instructions for modifying the language include instructions for redefining one or more data types.

2040. The general purpose computing machine of aspect 1998, wherein instructions for modifying the language include instructions for replacing one or more data types.

2041. The general purpose computing machine of aspect 1999, wherein instructions for modifying the language include instructions for redefining one or more data types.

2042. The general purpose computing machine of aspect 1999, wherein instructions for modifying the language include instructions for replacing one or more data types.

2043. The general purpose computing machine of aspect 2000, wherein instructions for modifying the language include instructions for redefining one or more data types.

2044. The general purpose computing machine of aspect 2000, wherein instructions for modifying the language include instructions for replacing one or more data types.

2045. The general purpose computing machine of aspect 2001, wherein instructions for modifying the language include instructions for redefining one or more data types.

2046. The general purpose computing machine of aspect 2001, wherein instructions for modifying the language include instructions for replacing one or more data types.

2047. The general purpose computing machine of aspect 2002, wherein instructions for modifying the language include instructions for redefining one or more data types.

2048. The general purpose computing machine of aspect 2002, wherein instructions for modifying the language include instructions for replacing one or more data types.

2049. The general purpose computing machine of aspect 2003, wherein instructions for modifying the language include instructions for redefining one or more data types.

2050. The general purpose computing machine of aspect 2003, wherein instructions for modifying the language include instructions for replacing one or more data types.

2051. The general purpose computing machine of aspect 2004, wherein instructions for the language include instructions for redefining one or more data types.

2052. The general purpose computing machine of aspect 2004, wherein instructions for the language include instructions for replacing one or more data types.

2053. The general purpose computing machine of aspect 2005, wherein instructions for modifying the language include instructions for redefining one or more data types.

2054. The general purpose computing machine of aspect 2005, wherein instructions for modifying the language include instructions for replacing one or more data types.

2055. The general purpose computing machine of aspect 2006, wherein instructions for modifying the language include instructions for redefining one or more data types.

2056. The general purpose computing machine of aspect 2006, wherein instructions for modifying the language include instructions for replacing one or more data types.

2057. The general purpose computing machine of aspect 2007, wherein instructions for modifying the language include instructions for redefining one or more data types.

2058. The general purpose computing machine of aspect 2007, wherein instructions for modifying the language include instructions for replacing one or more data types.

2059. The general purpose computing machine of aspect 2008, wherein instructions for modifying the language include instructions for redefining one or more data types.

2060. The general purpose computing machine of aspect 2008, wherein instructions for modifying the language include instructions for replacing one or more data types.

2061. The general purpose computing machine of aspect 1983 wherein the instructions when executed further cause the general purpose computing machine to perform: verifying that all programs created in the language have decidable and complete data flow.

2062. A general purpose computing machine comprising (i) a storage device including one or more sets of instructions stored thereon and (ii) a processor adapted to execute the one or more sets of instructions, wherein the execution of the one or more sets of instructions includes:
specifying a known programming language; and
modifying the language wherein the modified language satisfies both a finite code path property and a data flow property.

2063. The general purpose computing machine of aspect 2062 wherein the instructions when executed further cause the general purpose computing machine to perform verifying compliance with the finite code path property.

2064. The general purpose computing machine of aspect 2062 wherein the instructions when executed further cause the general purpose computing machine to perform verifying compliance with the data flow property.

2065. The general purpose computing machine of aspect 2063 wherein the instructions when executed further cause the general purpose computing machine to perform verifying compliance with the data flow property.

2066. The general purpose computing machine of aspect 2062 wherein said modifying the language includes redefining one or more data types.

2067. The general purpose computing machine of aspect 2063 wherein said modifying the language includes redefining one or more data types.

2068. The general purpose computing machine of aspect 2064 wherein said modifying the language includes redefining one or more data types.

2069. The general purpose computing machine of aspect 2065 wherein said modifying the language includes redefining one or more data types.

2070. The general purpose computing machine of aspect 2062 wherein said modifying the language includes replacing one or more operators having ambiguous semantics with replacement operators having unambiguous semantics.

2071. The general purpose computing machine of aspect 2063 wherein said modifying the language includes replacing one or more operators having ambiguous semantics with replacement operators having unambiguous semantics.

2072. The general purpose computing machine of aspect 2064 wherein said modifying the language includes replacing one or more operators having ambiguous semantics with replacement operators having unambiguous semantics.

2073. The general purpose computing machine of aspect 2065 wherein said modifying the language includes replacing one or more operators having ambiguous semantics with replacement operators having unambiguous semantics.

2074. The general purpose computing machine of aspect 2066 wherein said modifying the language includes replacing one or more operators having ambiguous semantics with replacement operators having unambiguous semantics.

2075. The general purpose computing machine of aspect 2067 wherein said modifying the language includes replacing one or more operators having ambiguous semantics with replacement operators having unambiguous semantics.

2076. The general purpose computing machine of aspect 2068 wherein said modifying the language includes replacing one or more operators having ambiguous semantics with replacement operators having unambiguous semantics.

2077. The general purpose computing machine of aspect 2069 wherein said modifying the language includes replacing one or more operators having ambiguous semantics with replacement operators having unambiguous semantics.

2078. The general purpose computing machine of aspect 2066 wherein the redefined data types comprise enumerable and non-enumerable data types.

2079. The general purpose computing machine of aspect 2067 wherein the redefined data types comprise enumerable and non-enumerable data types.

2080. The general purpose computing machine of aspect 2068 wherein the redefined data types comprise enumerable and non-enumerable data types.

2081. The general purpose computing machine of aspect 2069 wherein the redefined data types comprise enumerable and non-enumerable data types.

2082. The general purpose computing machine of aspect 2066 wherein the redefined data types comprise enumerable and non-enumerable data types.

2083. The general purpose computing machine of aspect 2078 wherein all data elements of the non-enumerated data types are represented as sets.

2084. The general purpose computing machine of aspect 2079 wherein all data elements of the non-enumerated data types are represented as sets.

2085. The general purpose computing machine of aspect 2080 wherein all data elements of the non-enumerated data types are represented as sets.

2086. The general purpose computing machine of aspect 2081 wherein all data elements of the non-enumerated data types are represented as sets.

2087. The general purpose computing machine of aspect 2082 wherein all data elements of the non-enumerated data types are represented as sets.

2088. The general purpose computing machine of aspect 2083 wherein all data elements consisting of infinite sets are expressed with a finite lexical notation.

2089. The general purpose computing machine of aspect 2084 wherein all data elements consisting of infinite sets are expressed with a finite lexical notation.

2090. The general purpose computing machine of aspect 2085 wherein all data elements consisting of infinite sets are expressed with a finite lexical notation.

2091. The general purpose computing machine of aspect 2086 wherein all data elements consisting of infinite sets are expressed with a finite lexical notation.

2092. The general purpose computing machine of aspect 2087 wherein all data elements consisting of infinite sets are expressed with a finite lexical notation.

2093. The general purpose computing machine of aspect 2083 wherein numeric data types are non-enumerated data types and numeric data elements of the numeric data types are expressed using equalities and/or inequalities.

2094. The general purpose computing machine of aspect 2084 wherein numeric data types are non-enumerated data types and numeric data elements of the numeric data types are expressed using equalities and/or inequalities.

2095. The general purpose computing machine of aspect 2085 wherein numeric data types are non-enumerated data types and numeric data elements of the numeric data types are expressed using equalities and/or inequalities.

2096. The general purpose computing machine of aspect 2086 wherein numeric data types are non-enumerated data types and numeric data elements of the numeric data types are expressed using equalities and/or inequalities.

2097. The general purpose computing machine of aspect 2087 wherein numeric data types are non-enumerated data types and numeric data elements of the numeric data types are expressed using equalities and/or inequalities.

2098. The general purpose computing machine of aspect 2063 wherein said verifying compliance with the finite code path property includes demonstrating all possible code paths within the language can be expressed in a finite tree model.

2099. The general purpose computing machine of aspect 2098, wherein the tree model comprises a directed acyclic graph.

2100. The general purpose computing machine of aspect 2099 wherein said demonstrating all possible code paths within the language includes generating a tree model using a tableau algorithm.

2101. The general purpose computing machine of aspect 2098 wherein said demonstrating all possible code paths within the language includes generating a tree model using a tableau algorithm.

2102. The general purpose computing machine of aspect 2098 wherein said demonstrating all possible code paths within the language includes generating a tree model using a model search algorithm.

2103. The general purpose computing machine of aspect 2064 wherein said further comprising verifying compliance with the finite code path property includes demonstrating all possible code paths within the language can be expressed in a finite tree model.

2104. The general purpose computing machine of aspect 2103, wherein the tree model comprises a directed acyclic graph.

2105. The general purpose computing machine of aspect 2104 wherein said demonstrating all possible code paths within the language includes generating a tree model using a tableau algorithm.

2106. The general purpose computing machine of aspect 2076 wherein said demonstrating all possible code paths within the language includes generating a tree model using a tableau algorithm.

2107. The general purpose computing machine of aspect 2076 wherein said demonstrating all possible code paths within the language includes generating a tree model using a model search algorithm.

2108. The general purpose computing machine of aspect 2065 wherein said further comprising verifying compliance with the finite code path property includes demonstrating all possible code paths within the language can be expressed in a finite tree model.

2109. The general purpose computing machine of aspect 2108, wherein the tree model comprises a directed acyclic graph.

2110. The general purpose computing machine of aspect 2109 wherein said demonstrating all possible code paths within the language includes generating a tree model using a tableau algorithm.

2111. The general purpose computing machine of aspect 2108 wherein said demonstrating all possible code paths within the language includes generating a tree model using a tableau algorithm.

2112. The general purpose computing machine of aspect 2108 wherein said demonstrating all possible code paths within the language includes generating a tree model using a model search algorithm.

2113. The general purpose computing machine of aspect 2064, wherein said verifying compliance with the data flow property includes identifying a set of one or more complete and correct algorithms that can determine the value of any data element in the set of all programs written in the language.

2114. The general purpose computing machine of aspect 2113 wherein said identifying a set of one or more complete and correct algorithms includes demonstrating a valid algorithm for each data type associated with the language.

2115. The general purpose computing machine of aspect 2114, wherein said demonstrating a valid algorithm for each data type includes utilizing automated algebraic analysis.

2116. The general purpose computing machine of aspect 2114, wherein said demonstrating a valid algorithm for each data type includes utilizing approximation.

2117. The general purpose computing machine of aspect 2068, wherein said verifying compliance with the data flow property includes identifying a set of one or more complete and correct algorithms that can determine the value of any data element in the set of all programs written in the language.

2118. The general purpose computing machine of aspect 2117 wherein said identifying a set of one or more complete and correct algorithms includes demonstrating a valid algorithm for each data type associated with the language.

2119. The general purpose computing machine of aspect 2118, wherein said demonstrating a valid algorithm for each data type includes utilizing automated algebraic analysis.

2120. The general purpose computing machine of aspect 2118, wherein said demonstrating a valid algorithm for each data type includes utilizing approximation.

2121. The general purpose computing machine of aspect 2072, wherein said verifying compliance with the data flow property includes identifying a set of one or more complete and correct algorithms that can determine the value of any data element in the set of all programs written in the language.

2122. The general purpose computing machine of aspect 2121 wherein said identifying a set of one or more complete and correct algorithms includes demonstrating a valid algorithm for each data type associated with the language.

2123. The general purpose computing machine of aspect 2122, wherein said demonstrating a valid algorithm for each data type includes utilizing automated algebraic analysis.

2124. The general purpose computing machine of aspect 2122, wherein said demonstrating a valid algorithm for each data type includes utilizing approximation.

2125. The general purpose computing machine of aspect 2063, further comprising instructions that, when executed by general purpose computing machine, cause the general purpose computing machine to perform the following: repeating modifying the language after said verifying compliance with the finite code path property if compliance with the finite code path property is unverifiable.

2126. The general purpose computing machine of aspect 2125, wherein the operations of modifying and verifying are repeated iteratively until the finite code path property is verified.

2127. The general purpose computing machine of aspect 2065, further comprising instructions that, when executed by general purpose computing machine, cause the general purpose computing machine to perform the following: repeating modifying the language after said verifying compliance with the finite code path property if compliance with the finite code path property is unverifiable.

2128. The general purpose computing machine of aspect 2127, wherein the operations of modifying and verifying are repeated iteratively until the finite code path property is verified.

2129. The general purpose computing machine of aspect 2067, further comprising instructions that, when executed by general purpose computing machine, cause the general purpose computing machine to perform the following: repeating modifying the language after said verifying compliance with the finite code path property if compliance with the finite code path property is unverifiable.

2130. The general purpose computing machine of aspect 2129, wherein the operations of modifying and verifying are repeated iteratively until the finite code path property is verified.

2131. The general purpose computing machine of aspect 2069, further comprising instructions that, when executed by general purpose computing machine, cause the general purpose computing machine to perform the following: repeating modifying the language after said verifying compliance with the finite code path property if compliance with the finite code path property is unverifiable.

2132. The general purpose computing machine of aspect 2131, wherein the operations of modifying and verifying are repeated iteratively until the finite code path property is verified.

2133. The general purpose computing machine of aspect 2071, further comprising instructions that, when executed by general purpose computing machine, cause the general purpose computing machine to perform the following: repeating modifying the language after said verifying compliance with the finite code path property if compliance with the finite code path property is unverifiable.

2134. The general purpose computing machine of aspect 2133, wherein the operations of modifying and verifying are repeated iteratively until the finite code path property is verified.

2135. The general purpose computing machine of aspect 2075, further comprising instructions that, when executed by general purpose computing machine, cause the general purpose computing machine to perform the following: repeating modifying the language after said verifying compliance with the finite code path property if compliance with the finite code path property is unverifiable.

2136. The general purpose computing machine of aspect 2135, wherein the operations of modifying and verifying are repeated iteratively until the finite code path property is verified.

2137. The general purpose computing machine of aspect 2077, further comprising instructions that, when executed by general purpose computing machine, cause the general purpose computing machine to perform the following: repeating modifying the language after said verifying compliance with the finite code path property if compliance with the finite code path property is unverifiable.

2138. The general purpose computing machine of aspect 2137, wherein the operations of modifying and verifying are repeated iteratively until the finite code path property is verified.

2139. The general purpose computing machine of aspect 2079, further comprising instructions that, when executed by general purpose computing machine, cause the general purpose computing machine to perform the following: repeating modifying the language after said verifying compliance with the finite code path property if compliance with the finite code path property is unverifiable.

2140. The general purpose computing machine of aspect 2139, wherein the operations of modifying and verifying are repeated iteratively until the finite code path property is verified.

2141. The general purpose computing machine of aspect 2081, further comprising instructions that, when executed by general purpose computing machine, cause the general purpose computing machine to perform the following: repeating modifying the language after said verifying compliance with the finite code path property if compliance with the finite code path property is unverifiable.

2142. The general purpose computing machine of aspect 2141, wherein the operations of modifying and verifying are repeated iteratively until the finite code path property is verified.

2143. The general purpose computing machine of aspect 2084, further comprising instructions that, when executed by general purpose computing machine, cause the general purpose computing machine to perform the following: repeating modifying the language after said verifying compliance with the finite code path property if compliance with the finite code path property is unverifiable.

2144. The general purpose computing machine of aspect 2143, wherein the operations of modifying and verifying are repeated iteratively until the finite code path property is verified.

2145. The general purpose computing machine of aspect 2086, further comprising instructions that, when executed by general purpose computing machine, cause the general purpose computing machine to perform the following: repeating modifying the language after said verifying compliance with the finite code path property if compliance with the finite code path property is unverifiable.

2146. The general purpose computing machine of aspect 2145, wherein the operations of modifying and verifying are repeated iteratively until the finite code path property is verified.

2147. The general purpose computing machine of aspect 2089, further comprising instructions that, when executed by general purpose computing machine, cause the general purpose computing machine to perform the following: repeating modifying the language after said verifying compliance with the finite code path property if compliance with the finite code path property is unverifiable.

2148. The general purpose computing machine of aspect 2147, wherein the operations of modifying and verifying are repeated iteratively until the finite code path property is verified.

2149. The general purpose computing machine of aspect 2091, further comprising instructions that, when executed by general purpose computing machine, cause the general purpose computing machine to perform the following: repeating modifying the language after said verifying compliance with the finite code path property if compliance with the finite code path property is unverifiable.

2150. The general purpose computing machine of aspect 2149, wherein the operations of modifying and verifying are repeated iteratively until the finite code path property is verified.

2151. The general purpose computing machine of aspect 2094, further comprising instructions that, when executed by general purpose computing machine, cause the general purpose computing machine to perform the following: repeating modifying the language after said verifying compliance with the finite code path property if compliance with the finite code path property is unverifiable.

2152. The general purpose computing machine of aspect 2151, wherein the operations of modifying and verifying are repeated iteratively until the finite code path property is verified.

2153. The general purpose computing machine of aspect 2096, further comprising instructions that, when executed by general purpose computing machine, cause the general purpose computing machine to perform the following: repeating modifying the language after said verifying compliance with the finite code path property if compliance with the finite code path property is unverifiable.

2154. The general purpose computing machine of aspect 2153, wherein the operations of modifying and verifying are repeated iteratively until the finite code path property is verified.

2155. The general purpose computing machine of aspect 2098, further comprising instructions that, when executed by general purpose computing machine, cause the general purpose computing machine to perform the following: repeating modifying the language after said verifying compliance with the finite code path property if compliance with the finite code path property is unverifiable.

2156. The general purpose computing machine of aspect 2155, wherein the operations of modifying and verifying are repeated iteratively until the finite code path property is verified.

2157. The general purpose computing machine of aspect 2099, further comprising instructions that, when executed by general purpose computing machine, cause the general purpose computing machine to perform the following: repeating modifying the language after said verifying compliance with the finite code path property if compliance with the finite code path property is unverifiable.

2158. The general purpose computing machine of aspect 2157, wherein the operations of modifying and verifying are repeated iteratively until the finite code path property is verified.

2159. The general purpose computing machine of aspect 2100, further comprising instructions that, when executed by general purpose computing machine, cause the general purpose computing machine to perform the following: repeating modifying the language after said verifying compliance with the finite code path property if compliance with the finite code path property is unverifiable.

2160. The general purpose computing machine of aspect 2159, wherein the operations of modifying and verifying are repeated iteratively until the finite code path property is verified.

2161. The general purpose computing machine of aspect 2101, further comprising instructions that, when executed by general purpose computing machine, cause the general purpose computing machine to perform the following: repeating modifying the language after said verifying compliance with the finite code path property if compliance with the finite code path property is unverifiable.

2162. The general purpose computing machine of aspect 2161, wherein the operations of modifying and verifying are repeated iteratively until the finite code path property is verified.

2163. The general purpose computing machine of aspect 2102, further comprising instructions that, when executed by general purpose computing machine, cause the general purpose computing machine to perform the following: repeating modifying the language after said verifying compliance with the finite code path property if compliance with the finite code path property is unverifiable.

2164. The general purpose computing machine of aspect 2163, wherein the operations of modifying and verifying are repeated iteratively until the finite code path property is verified.

2165. The general purpose computing machine of aspect 2108, further comprising instructions that, when executed by general purpose computing machine, cause the general purpose computing machine to perform the following: repeating modifying the language after said verifying compliance with the finite code path property if compliance with the finite code path property is unverifiable.

2166. The general purpose computing machine of aspect 2165, wherein the operations of modifying and verifying are repeated iteratively until the finite code path property is verified.

2167. The general purpose computing machine of aspect 2111, further comprising instructions that, when executed by general purpose computing machine, cause the general purpose computing machine to perform the following: repeating modifying the language after said verifying compliance with the finite code path property if compliance with the finite code path property is unverifiable.

2168. The general purpose computing machine of aspect 2167, wherein the operations of modifying and verifying are repeated iteratively until the finite code path property is verified.

2169. The general purpose computing machine of aspect 2112, further comprising instructions that, when executed by general purpose computing machine, cause the general purpose computing machine to perform the following: repeating modifying the language after said verifying compliance with the finite code path property if compliance with the finite code path property is unverifiable.

2170. The general purpose computing machine of aspect 2169, wherein the operations of modifying and verifying are repeated iteratively until the finite code path property is verified.

2171. A machine-readable medium having stored thereon instructions for software quality control that, when executed by one or more machines, cause the one or more machines to perform the following:
generating a parse tree;
generating a code path set based on the parse tree;
generating a path data model set using the code path set; and
generating a finite input/output semantic model (FIOSM) from the path data model set.

2172. The machine-readable medium of aspect 2171, wherein the generation of a finite input/output semantic model dictates that the software has a completely decidable data flow.

2173. The machine-readable medium of aspect 2171 wherein said generating a parse tree comprises parsing the source code of a software procedure.

2174. The machine-readable medium of aspect 2171 wherein said generating a parse tree comprises parsing the source code of a software program.

2175. The machine-readable medium of aspect 2171 wherein the parse tree comprises a directed acyclic graph structure (DAG).

2176. The machine-readable medium of aspect 2173, wherein the source code is written in a FIOSM compliant programming language.

2177. The machine-readable medium of aspect 2174, wherein the source code is written in a FIOSM compliant programming language.

2178. The machine-readable medium of aspect 2171, wherein said generating a code path set based on the parse tree comprises utilizing a suitable algorithm to walk the parse tree.

2179. The machine-readable medium of aspect 2171, wherein the code path set comprises condition free code path trees.

2180. The machine-readable medium of aspect 2178, wherein the suitable algorithm comprises a tableau algorithm.

2181. The machine-readable medium of aspect 2178, wherein the suitable algorithm comprises a book-marking algorithm.

2182. The machine-readable medium of aspect 2171, wherein the path data model set comprises a plurality of logically consistent data element models.

2183. The machine-readable medium of aspect 2182, wherein said generating a path data model set using the code path set includes discarding any logically inconsistent data element models.

2184. The machine-readable medium of aspect 2171, wherein said generating a path data model set using the code path set comprises for each code path set element: (i) walking the code path parse tree of the code path set element; (ii) recording assignments and constraints for the code path set element.

2185. The machine-readable medium of aspect 2171, wherein said generating a path data model set using the code path set comprises converting the code path set into a set of logically consistent data model elements.

2186. The machine-readable medium of aspect 2171, wherein said generating a finite input/output semantic model (FIOSM) from the path data model set comprises: (i) identifying a set of input data elements in the program; (ii) identifying a set of output data elements; (iii) for each member of the path data model set, creating a input-output pattern expression; (iv) for each input data element, generating an input data expression and adding it to an input set; and (v) for each output data element, generating an output data expression and adding it to an output set.

2187. The machine-readable medium of aspect 2186, wherein said formatting a FIOSM from the path data model set further comprises: eliminating intermediate data elements.

2188. A machine-readable medium having stored thereon instructions that, when executed by one or more machines, cause the one or more machines to generate a finite input output model (FIOSM) for a predetermined software program written in an FIOSM-compliant language.

2189. The machine-readable medium of aspect 2188, wherein the sequences of instructions further cause the one or more machines to create a FIOSM compliant language.

2190. The machine-readable medium of aspect 2188, wherein the sequences of instructions further cause the one or more machines to modify an existing computer language to be an FIOSM compliant language.

2191. The machine-readable medium of aspect 2188, wherein the sequences of instructions further cause the one or more machines to modify an existing non-FIOSM compliant computer language to be an FIOSM compliant language.

2192. The machine-readable medium of aspect 2188, wherein wherein the sequences of instructions further cause the one or more machines to generate a FIOSM further causes the one or more machines to:
parse the source code of the program to generate a parse tree;
generate a code path set using the parse tree;
generate a path data model set using the code path set; and
format a FIOSM from the path data model set.

2193. The machine-readable medium of aspect 2188, wherein the FIOSM consists of all possible inputs to the software program and all possible outputs the software program can generate based on all possible inputs.

2194. The machine-readable medium of aspect 2193, wherein the parse tree comprises a directed acyclic graph structure (DAG).

2195. The machine-readable medium of aspect 2192, wherein the parse tree comprises a directed acyclic graph structure (DAG).

2196. The machine-readable medium of aspect 2192, wherein the parse tree comprises a tree model

2197. The machine-readable medium of aspect 2192 wherein the instructions to generate code path sets using the parse tree utilize a suitable algorithm to walk the parse tree.

2198. The machine-readable medium of aspect 2197 wherein the suitable algorithm comprises a tableau algorithm.

2199. The machine-readable medium of aspect 2197 wherein the suitable algorithm comprises a model search algorithm.

2200. The machine-readable medium of aspect 2192 wherein the path data model set comprises a plurality of logically consistent data element models.

2201. The machine-readable medium of aspect 2197 wherein instructions to generate a path data model set using the code path set include instructions to discard any logically inconsistent data element models.

2202. The machine-readable medium of aspect 2192 wherein the instructions to generate a path data model set using the code path sets further include for each code path set element instructions to: (i) walk the code path parse tree of the code path set element; (ii) record assignments and constraints for the code path set element.

2203. The machine-readable medium of aspect 2192 wherein the instructions to format a FIOSM from the path data model set include instructions to: (i) identify a set of input data elements in the program; (ii) identify a set of output data elements; (iii) for each member of the path data model set, create a input-output pattern expression; (iv) for each input data element, generate an input data expression and adding it to an input set; and (v) for each output data element, generate an output data expression and adding it to an output set.

2204. The machine-readable medium of aspect 2203, wherein the instructions to format a FIOSM from the path data model set further instructions to: eliminate intermediate data elements.

2205. A machine-readable medium having stored thereon instructions concerning software engineering that, when executed on one or more machines, cause the one or more machines to perform operations employing a finite input/output semantic model (FIOSM).

2206. The machine-readable medium of aspect 2205 wherein said instructions employing a finite input/output semantic model further include instructions for designing a software programming language having decidable and complete dataflow wherein any and all software procedures created in the programming language can be represented by an FIOSM.

2207. The machine-readable medium of aspect 2205 wherein said instructions employing a finite input/output semantic model further include instructions for modifying an existing software programming language wherein any and all software procedures created in the programming language can be represented by an FIOSM.

2208. The machine-readable medium of aspect 2207 wherein the existing software language comprises one of C, C+, C++, Java, Basic, Pascal, and Fortran.

2209. The machine-readable medium of aspect 2207, wherein said instructions for modifying an existing software programming language further include instructions for removing all operators (i) having ambiguous semantics and (ii) being capable of invoking infinite code paths.

2210. The machine-readable medium of aspect 2207, wherein said instructions for modifying an existing software programming language further include instructions for removing all operators capable of invoking infinite code paths.

2211. The machine-readable medium of aspect 2209 wherein the existing software language comprises one of C, C+, C++, Java, Basic, Pascal, and Fortran.

2212. The machine-readable medium of aspect 2210 wherein the existing software language comprises one of C, C+, C++, Java, Basic, Pascal, and Fortran.

2213. The machine-readable medium of aspect 2209 further including instructions for replacing the removed operators with one or more alternative operators incapable of invoking infinite loops.

2214. The machine-readable medium of aspect 2210 further including instructions for replacing the removed operators with one or more alternative operators incapable of invoking infinite loops.

2215. The machine-readable medium of aspect 2211 further including instructions for replacing the removed operators with one or more alternative operators incapable of invoking infinite loops.

2216. The machine-readable medium of aspect 2212 further including instructions for replacing the removed operators with one or more alternative operators incapable of invoking infinite loops.

2217. The machine-readable medium of aspect 2209 further including instructions for replacing the removed operators with one or more alternative operators having unambiguous semantics.

2218. The machine-readable medium of aspect 2210 further including instructions for replacing the removed operators with one or more alternative operators having unambiguous semantics.

2219. The machine-readable medium of aspect 2211 further including instructions for replacing the removed operators with one or more alternative operators having unambiguous semantics.

2220. The machine-readable medium of aspect 2212 further including instructions for replacing the removed operators with one or more alternative operators having unambiguous semantics.

2221. The machine-readable medium of aspect 2209 wherein the instructions cause, when executed, a for loop operator to be replaced with “sum” operator.

2222. The machine-readable medium of aspect 2210 wherein the instructions cause, when executed, a for loop operator to be replaced with “sum” operator.

2223. The machine-readable medium of aspect 2211 wherein the instructions cause, when executed, a for loop operator to be replaced with “sum” operator.

2224. The machine-readable medium of aspect 2212 wherein the instructions cause, when executed, a for loop operator to be replaced with “sum” operator.

2225. The machine-readable medium of aspect 2207, wherein said instructions for modifying an existing software programming language includes instructions for redefining one or more data types.

2226. The machine-readable medium of aspect 2207, wherein said instructions for modifying an existing software programming language include instructions for replacing one or more data types.

2227. The machine-readable medium of aspect 2208, wherein said instructions for modifying an existing software programming language includes instructions for redefining one or more data types.

2228. The machine-readable medium of aspect 2208, wherein said instructions for modifying an existing software programming language include instructions for replacing one or more data types.

2229. The machine-readable medium of aspect 2209, wherein said instructions for modifying an existing software programming language includes instructions for redefining one or more data types.

2230. The machine-readable medium of aspect 2209, wherein said instructions for modifying an existing software programming language include instructions for replacing one or more data types.

2231. The machine-readable medium of aspect 2210, wherein said instructions for modifying an existing software programming language includes instructions for redefining one or more data types.

2232. The machine-readable medium of aspect 2210, wherein said instructions for modifying an existing software programming language include instructions for replacing one or more data types.

2233. The machine-readable medium of aspect 2211, wherein said instructions for modifying an existing software programming language includes instructions for redefining one or more data types.

2234. The machine-readable medium of aspect 2211, wherein said instructions for modifying an existing software programming language include instructions for replacing one or more data types.

2235. The machine-readable medium of aspect 2212, wherein said instructions for modifying an existing software programming language includes instructions for redefining one or more data types.

2236. The machine-readable medium of aspect 2212, wherein said instructions for modifying an existing software programming language include instructions for replacing one or more data types.

2237. The machine-readable medium of aspect 2213, wherein said instructions for modifying an existing software programming language includes instructions for redefining one or more data types.

2238. The machine-readable medium of aspect 2213, wherein said instructions for modifying an existing software programming language include instructions for replacing one or more data types.

2239. The machine-readable medium of aspect 2214, wherein said instructions for modifying an existing software programming language includes instructions for redefining one or more data types.

2240. The machine-readable medium of aspect 2214, wherein said instructions for modifying an existing software programming language include instructions for replacing one or more data types.

2241. The machine-readable medium of aspect 2215, wherein said instructions for modifying an existing software programming language includes instructions for redefining one or more data types.

2242. The machine-readable medium of aspect 2215, wherein said instructions for modifying an existing software programming language include instructions for replacing one or more data types.

2243. The machine-readable medium of aspect 2216, wherein said instructions for modifying an existing software programming language includes instructions for redefining one or more data types.

2244. The machine-readable medium of aspect 2216, wherein said instructions for modifying an existing software programming language include instructions for replacing one or more data types.

2245. The machine-readable medium of aspect 2217, wherein said instructions for modifying an existing software programming language includes instructions for redefining one or more data types.

2246. The machine-readable medium of aspect 2217, wherein said instructions for modifying an existing software programming language include instructions for replacing one or more data types.

2247. The machine-readable medium of aspect 2218, wherein said instructions for modifying an existing software programming language includes instructions for redefining one or more data types.

2248. The machine-readable medium of aspect 2218, wherein said instructions for modifying an existing software programming language include instructions for replacing one or more data types.

2249. The machine-readable medium of aspect 2219, wherein said instructions for modifying an existing software programming language includes instructions for redefining one or more data types.

2250. The machine-readable medium of aspect 2219, wherein said instructions for modifying an existing software programming language include instructions for replacing one or more data types.

2251. The machine-readable medium of aspect 2220, wherein said instructions for modifying an existing software programming language includes instructions for redefining one or more data types.

2252. The machine-readable medium of aspect 2220, wherein said instructions for modifying an existing software programming language include instructions for replacing one or more data types.

2253. The machine-readable medium of aspect 2206 wherein said instructions for designing a software programming language having decidable and complete dataflow include instructions for: (i) defining operators; and (ii) defining data types.

2254. The machine-readable medium of aspect 2253 further including instructions stored thereon for: verifying the decidable and complete data flow.

2255. The machine-readable medium of aspect 2253 wherein said instructions for defining operators include only specifying operators whose semantics are not ambiguous or cannot invoke infinite code paths.

2256. The machine-readable medium of aspect 2254 wherein said instructions for defining operators includes only specifying operators whose semantics are not ambiguous or cannot invoke infinite code paths.

2257. The machine-readable medium of aspect 2253 wherein the instructions when executed cause the one or more machine to represent the data types as enumerable and non-enumerable data types.

2258. The machine-readable medium of aspect 2253 that when executed on the one or more machines represent all data elements of the non-enumerated data types as sets.

2259. The machine-readable medium of aspect 2258 wherein the instructions require that all data elements consisting of infinite sets are expressed with a finite lexical notation when executed on the one or more machines.

2260. The machine-readable medium of aspect 2258 that, when executed, cause the one or more machines to represent numeric data types are non-enumerated data types and express numeric data elements of the numeric data types using equalities and/or inequalities.

2261. The machine-readable medium of aspect 2254 wherein the instructions when executed cause the one or more machine to represent the data types as enumerable and non-enumerable data types.

2262. The machine-readable medium of aspect 2254 that when executed on the one or more machines represent all data elements of the non-enumerated data types as sets.

2263. The machine-readable medium of aspect 2262 wherein the instructions require that all data elements consisting of infinite sets are expressed with a finite lexical notation when executed on the one or more machines.

2264. The machine-readable medium of aspect 2262 that, when executed, cause the one or more machines to represent numeric data types are non-enumerated data types and express numeric data elements of the numeric data types using equalities and/or inequalities.

2265. The machine-readable medium of aspect 2255 wherein the instructions when executed cause the one or more machine to represent the data types as enumerable and non-enumerable data types.

2266. The machine-readable medium of aspect 2255 that when executed on the one or more machines represent all data elements of the non-enumerated data types as sets.

2267. The machine-readable medium of aspect 2266 wherein the instructions require that all data elements consisting of infinite sets are expressed with a finite lexical notation when executed on the one or more machines.

2268. The machine-readable medium of aspect 2266 that, when executed, cause the one or more machines to represent numeric data types are non-enumerated data types and express numeric data elements of the numeric data types using equalities and/or inequalities.

2269. The machine-readable medium of aspect 2256 wherein the instructions when executed cause the one or more machine to represent the data types as enumerable and non-enumerable data types.

2270. The machine-readable medium of aspect 2256 that when executed on the one or more machines represent all data elements of the non-enumerated data types as sets.

2271. The machine-readable medium of aspect 2270 wherein the instructions require that all data elements consisting of infinite sets are expressed with a finite lexical notation when executed on the one or more machines.

2272. The machine-readable medium of aspect 2270 that, when executed, cause the one or more machines to represent numeric data types are non-enumerated data types and express numeric data elements of the numeric data types using equalities and/or inequalities.

2273. The machine-readable medium of aspect 2254 wherein said instructions for verifying decidable and complete data flow include instructions for verifying both a code path quality and a data flow quality of the language.

2274. The machine-readable medium of aspect 2273 wherein said instructions for verifying a code path quality include instructions for demonstrating all possible code paths within the language can be expressed in a finite tree model.

2275. The machine-readable medium of aspect 2274, wherein the tree model comprises a directed acyclic graph.

2276. The machine-readable medium of aspect 2274, wherein said instructions for demonstrating all possible code paths within the language include instructions for generating a tree model using a tableau algorithm.

2277. The machine-readable medium of aspect 2274, wherein said instructions for demonstrating all possible code paths within the language include instructions for generating a tree model using a model search algorithm.

2278. The machine-readable medium of aspect 2273, wherein instructions for verifying the data flow quality further include instructions for identifying a set of one or more complete and correct algorithms that can determine the value of any data element in the set of all programs written in the language.

2279. The machine-readable medium of aspect 2278 wherein instructions for identifying a set of one or more complete and correct algorithms include instructions for demonstrating a valid algorithm for each data type associated with the language.

2280. The machine-readable medium of aspect 2279, wherein instructions for demonstrating a valid algorithm for each data type include instructions for utilizing automated algebraic analysis.

2281. The machine-readable medium of aspect 2279, wherein instructions for demonstrating a valid algorithm for each data type include instructions for utilizing approximation.

2282. The machine-readable medium of aspect 2254, further including instructions that when executed on the one or more machines cause the machines to: repeat said designing the language after said verifying the decidable and complete data flow if decidable and complete data flow is unverifiable.

2283. The machine-readable medium of aspect 2211, wherein the instructions for the operations of designing and verifying are executed by the one or more machines repeatedly until decidable and complete data flow is verified.

2284. The machine-readable medium of aspect 2205 wherein instructions for employing a finite input/output semantic model include instructions for generating a software procedure and a corresponding FIOSM for the software procedure.

2285. The machine-readable medium of aspect 2205 wherein instructions for employing a finite input/output semantic model include instructions for generating a software routine and a corresponding FIOSM for the software routine.

2286. The machine-readable medium of aspect 2205 wherein instructions for employing a finite input/output semantic model include instructions for generating a software program and a corresponding FIOSM for the software program.

2287. The machine-readable medium of aspect 2205 wherein instructions for employing a finite input/output semantic model include instructions for generating a software module and a corresponding FIOSM for the software module.

2288. The machine-readable medium of aspect 2205 wherein instructions for employing a finite input/output semantic model include instructions for generating a software enterprise system and a corresponding FIOSM for the software enterprise system.

2289. A machine-readable medium having stored thereon sequences of instructions for generating a finite input/output semantic model that, when executed by one or more machines, cause the one or more machines to perform the following:
receiving a source program;
parsing the source program into an abstract data structure;
generating a set of code paths based on the abstract data structure;
converting the set of code paths into a set of logically consistent data element models;
utilizing the set of logically consistent data element models to format the finite input/output semantic model including:
   identifying a set of input data elements in the source program,
   identifying a set of output data elements in the source program, and for each set of data elements, creating an input-output pattern expression;
producing a valid data expression for each set of input data elements; and
   producing a valid data expression for each set of output data elements.

2290. The machine-readable medium of aspect 2289 wherein the abstract data structure comprises a parse tree.

2291. The machine-readable medium of aspect 2289 wherein the abstract data structure comprises a tree model.

2292. The machine-readable medium of aspect 2289 wherein the abstract data structure comprises a directed acyclic graph structure.

2293. The machine-readable medium of aspect 2290 wherein instructions for generating a set of code paths based on the abstract data structure include instructions for walking the parse tree.

2294. The machine-readable medium of aspect 2290 wherein instructions for generating a set of code paths based on the abstract data structure include instructions for using a suitable algorithm to walk the parse tree.

2295. The machine-readable medium of aspect 2294 wherein the suitable algorithm is a model-splitting type algorithm.

2296. The machine-readable medium of aspect 2295 wherein the model-splitting type algorithm is a member of the Tableau family of algorithms.

2297. The machine-readable medium of aspect 2294 wherein the suitable algorithm is a book-marking type algorithm.

2298. The machine-readable medium of aspect 2294 wherein the suitable algorithm is a model search algorithm.

2299. The machine-readable medium of aspect 2289 wherein each data element model of the set of logically consistent data element models represents one input-output pattern of the source program.

2300. The machine-readable medium of aspect 2289, wherein instructions for converting the set of code paths into a set of logically consistent data element models include instructions for discarding logically inconsistent data element models from the set of code paths.

2301. The machine-readable medium of aspect 2289, wherein instructions for converting the set of code paths into a set of logically consistent data element models include instructions for (i) walking the set of code paths, (ii) generating the set of data element models, and (iii) testing each data element model of the set for data-element consistency.

2302. A machine-readable medium having stored thereon instructions that, when executed by one or more machines, cause the one or more machines to perform the following:
specifying a known programming language; and
modifying the language wherein any program written in the language is finite input output semantic model compliant.

2303. The machine-readable medium of aspect 2302 wherein the known programming language comprises one of: C, C+, C++, Java, Basic, Pascal, and Fortran.

2304. The machine-readable medium of aspect 2302, wherein instructions for modifying language include instructions for removing all operators (i) having ambiguous semantics and (ii) being capable of invoking infinite code paths.

2305. The machine-readable medium of aspect 2303, wherein instructions for modifying language include instructions for removing all operators (i) having ambiguous semantics and (ii) being capable of invoking infinite code paths.

2306. The machine-readable medium of aspect 2302, wherein instructions for modifying an existing software programming language include instructions for removing all operators capable of invoking infinite code paths.

2307. The machine-readable medium of aspect 2303, wherein instructions for modifying an existing software programming language include instructions for removing all operators capable of invoking infinite code paths.

2308. The machine-readable medium of aspect 2304 wherein the instructions when executed further cause the one or more machines to perform: replacing the removed operators with one or more alternative operators incapable of invoking infinite loops.

2309. The machine-readable medium of aspect 2305 wherein the instructions when executed further cause the one or more machines to perform: replacing the removed operators with one or more alternative operators incapable of invoking infinite loops.

2310. The machine-readable medium of aspect 2306 wherein the instructions when executed further cause the one or more machines to perform: replacing the removed operators with one or more alternative operators incapable of invoking infinite loops.

2311. The machine-readable medium of aspect 2307 wherein the instructions when executed further cause the one or more machines to perform: replacing the removed operators with one or more alternative operators incapable of invoking infinite loops.

2312. The machine-readable medium of aspect 2304 wherein the instructions when executed further cause the one or more machines to perform: replacing the removed operators with one or more alternative operators having unambiguous semantics.

2313. The machine-readable medium of aspect 2305 wherein the instructions when executed further cause the one or more machines to perform: replacing the removed operators with one or more alternative operators having unambiguous semantics.

2314. The machine-readable medium of aspect 2306 wherein the instructions when executed further cause the one or more machines to perform: replacing the removed operators with one or more alternative operators having unambiguous semantics.

2315. The machine-readable medium of aspect 2307 wherein the instructions when executed further cause the one or more machines to perform: replacing the removed operators with one or more alternative operators having unambiguous semantics.

2316. The machine-readable medium of aspect 2304 wherein the instructions cause the one or more machines to replace a for loop operator with “sum” operator.

2317. The machine-readable medium of aspect 2305 wherein the instructions cause the one or more machines to replace a for loop operator with “sum” operator.

2318. The machine-readable medium of aspect 2306 wherein the instructions cause the one or more machines to replace a for loop operator with “sum” operator.

2319. The machine-readable medium of aspect 2307 wherein the instructions cause the one or more machines to replace a for loop operator with “sum” operator.

2320. The machine-readable medium of aspect 2308 wherein the instructions cause the one or more machines to replace a for loop operator with “sum” operator.

2321. The machine-readable medium of aspect 2309 wherein the instructions cause the one or more machines to replace a for loop operator with “sum” operator.

2322. The machine-readable medium of aspect 2310 wherein the instructions cause the one or more machines to replace a for loop operator with “sum” operator.

2323. The machine-readable medium of aspect 2311 wherein the instructions cause the one or more machines to replace a for loop operator with “sum” operator.

2324. The machine-readable medium of aspect 2312 wherein the instructions cause the one or more machines to replace a for loop operator with “sum” operator.

2325. The machine-readable medium of aspect 2313 wherein the instructions cause the one or more machines to replace a for loop operator with “sum” operator.

2326. The machine-readable medium of aspect 2314 wherein the instructions cause the one or more machines to replace a for loop operator with “sum” operator.

2327. The machine-readable medium of aspect 2315 wherein the instructions cause the one or more machines to replace a for loop operator with “sum” operator.

2328. The machine-readable medium of aspect 2302, wherein instructions for modifying the language include instructions for redefining one or more data types.

2329. The machine-readable medium of aspect 2302, wherein instructions for modifying the language include instructions for replacing one or more data types.

2330. The machine-readable medium of aspect 2303, wherein instructions for modifying the language include instructions for redefining one or more data types.

2331. The machine-readable medium of aspect 2303, wherein instructions for modifying the language include instructions for replacing one or more data types.

2332. The machine-readable medium of aspect 2304, wherein instructions for modifying the language include instructions for redefining one or more data types.

2333. The machine-readable medium of aspect 2304, wherein instructions for modifying the language include instructions for replacing one or more data types.

2334. The machine-readable medium of aspect 2305, wherein instructions for modifying the language include instructions for redefining one or more data types.

2335. The machine-readable medium of aspect 2305, wherein instructions for modifying the language include instructions for replacing one or more data types.

2336. The machine-readable medium of aspect 2306, wherein instructions for modifying the language include instructions for redefining one or more data types.

2337. The machine-readable medium of aspect 2306, wherein instructions for modifying the language include instructions for replacing one or more data types.

2338. The machine-readable medium of aspect 2307, wherein instructions for modifying the language include instructions for redefining one or more data types.

2339. The machine-readable medium of aspect 2307, wherein instructions for modifying the language include instructions for replacing one or more data types.

2340. The machine-readable medium of aspect 2308, wherein instructions for modifying the language include instructions for redefining one or more data types.

2341. The machine-readable medium of aspect 2308, wherein instructions for modifying the language include instructions for replacing one or more data types.

2342. The machine-readable medium of aspect 2309, wherein instructions for modifying the language include instructions for redefining one or more data types.

2343. The machine-readable medium of aspect 2309, wherein instructions for modifying the language include instructions for replacing one or more data types.

2344. The machine-readable medium of aspect 2310, wherein instructions for modifying the language include instructions for redefining one or more data types.

2345. The machine-readable medium of aspect 2310, wherein instructions for modifying the language include instructions for replacing one or more data types.

2346. The machine-readable medium of aspect 2311, wherein instructions for modifying the language include instructions for redefining one or more data types.

2347. The machine-readable medium of aspect 2311, wherein instructions for modifying the language include instructions for replacing one or more data types.

2348. The machine-readable medium of aspect 2312, wherein instructions for modifying the language include instructions for redefining one or more data types.

2349. The machine-readable medium of aspect 2312, wherein instructions for modifying the language include instructions for replacing one or more data types.

2350. The machine-readable medium of aspect 2313, wherein instructions for modifying the language include instructions for redefining one or more data types.

2351. The machine-readable medium of aspect 2313, wherein instructions for modifying the language include instructions for replacing one or more data types.

2352. The machine-readable medium of aspect 2314, wherein instructions for modifying the language include instructions for redefining one or more data types.

2353. The machine-readable medium of aspect 2314, wherein instructions for modifying the language include instructions for replacing one or more data types.

2354. The machine-readable medium of aspect 2315, wherein instructions for modifying the language include instructions for redefining one or more data types.

2355. The machine-readable medium of aspect 2315, wherein instructions for modifying the language include instructions for replacing one or more data types.

2356. The machine-readable medium of aspect 2316, wherein instructions for modifying the language include instructions for redefining one or more data types.

2357. The machine-readable medium of aspect 2316, wherein instructions for modifying the language include instructions for replacing one or more data types.

2358. The machine-readable medium of aspect 2317, wherein instructions for modifying the language include instructions for redefining one or more data types.

2359. The machine-readable medium of aspect 2317, wherein instructions for modifying the language include instructions for replacing one or more data types.

2360. The machine-readable medium of aspect 2318, wherein instructions for modifying the language include instructions for redefining one or more data types.

2361. The machine-readable medium of aspect 2318, wherein instructions for modifying the language include instructions for replacing one or more data types.

2362. The machine-readable medium of aspect 2319, wherein instructions for modifying the language include instructions for redefining one or more data types.

2363. The machine-readable medium of aspect 2319, wherein instructions for modifying the language include instructions for replacing one or more data types.

2364. The machine-readable medium of aspect 2320, wherein instructions for modifying the language include instructions for redefining one or more data types.

2365. The machine-readable medium of aspect 2320, wherein instructions for modifying the language include instructions for replacing one or more data types.

2366. The machine-readable medium of aspect 2321, wherein instructions for modifying the language include instructions for redefining one or more data types.

2367. The machine-readable medium of aspect 2321, wherein instructions for modifying the language include instructions for replacing one or more data types.

2368. The machine-readable medium of aspect 2322, wherein instructions for modifying the language include instructions for redefining one or more data types.

2369. The machine-readable medium of aspect 2322, wherein instructions for modifying the language include instructions for replacing one or more data types.

2370. The machine-readable medium of aspect 2323, wherein instructions for the language include instructions for redefining one or more data types.

2371. The machine-readable medium of aspect 2323, wherein instructions for the language include instructions for replacing one or more data types.

2372. The machine-readable medium of aspect 2324, wherein instructions for modifying the language include instructions for redefining one or more data types.

2373. The machine-readable medium of aspect 2324, wherein instructions for modifying the language include instructions for replacing one or more data types.

2374. The machine-readable medium of aspect 2325, wherein instructions for modifying the language include instructions for redefining one or more data types.

2375. The machine-readable medium of aspect 2325, wherein instructions for modifying the language include instructions for replacing one or more data types.

2376. The machine-readable medium of aspect 2326, wherein instructions for modifying the language include instructions for redefining one or more data types.

2377. The machine-readable medium of aspect 2326, wherein instructions for modifying the language include instructions for replacing one or more data types.

2378. The machine-readable medium of aspect 2327, wherein instructions for modifying the language include instructions for redefining one or more data types.

2379. The machine-readable medium of aspect 2327, wherein instructions for modifying the language include instructions for replacing one or more data types.

2380. The machine-readable medium of aspect 2302 wherein the instructions when executed further cause the one or more machines to perform: verifying that all programs created in the language have decidable and complete data flow.

2381. A machine-readable medium having stored thereon instructions that, when executed by one or more machines, cause the one or more machines to perform the following:
specifying a known programming language; and
modifying the language wherein the modified language satisfies both a finite code path property and a data flow property.

2382. The machine-readable medium of aspect 2381 wherein the instructions when executed further cause the one or more machines to perform verifying compliance with the finite code path property.

2383. The machine-readable medium of aspect 2381 wherein the instructions when executed further cause the one or more machines to perform verifying compliance with the data flow property.

2384. The machine-readable medium of aspect 2382 wherein the instructions when executed further cause the one or more machines to perform verifying compliance with the data flow property.

2385. The machine-readable medium of aspect 2381 wherein said modifying the language includes redefining one or more data types.

2386. The machine-readable medium of aspect 2382 wherein said modifying the language includes redefining one or more data types.

2387. The machine-readable medium of aspect 2383 wherein said modifying the language includes redefining one or more data types.

2388. The machine-readable medium of aspect 2384 wherein said modifying the language includes redefining one or more data types.

2389. The machine-readable medium of aspect 2381 wherein said modifying the language includes replacing one or more operators having ambiguous semantics with replacement operators having unambiguous semantics.

2390. The machine-readable medium of aspect 2382 wherein said modifying the language includes replacing one or more operators having ambiguous semantics with replacement operators having unambiguous semantics.

2391. The machine-readable medium of aspect 2383 wherein said modifying the language includes replacing one or more operators having ambiguous semantics with replacement operators having unambiguous semantics.

2392. The machine-readable medium of aspect 2384 wherein said modifying the language includes replacing one or more operators having ambiguous semantics with replacement operators having unambiguous semantics.

2393. The machine-readable medium of aspect 2385 wherein said modifying the language includes replacing one or more operators having ambiguous semantics with replacement operators having unambiguous semantics.

2394. The machine-readable medium of aspect 2386 wherein said modifying the language includes replacing one or more operators having ambiguous semantics with replacement operators having unambiguous semantics.

2395. The machine-readable medium of aspect 2387 wherein said modifying the language includes replacing one or more operators having ambiguous semantics with replacement operators having unambiguous semantics.

2396. The machine-readable medium of aspect 2388 wherein said modifying the language includes replacing one or more operators having ambiguous semantics with replacement operators having unambiguous semantics.

2397. The machine-readable medium of aspect 2385 wherein the redefined data types comprise enumerable and non-enumerable data types.

2398. The machine-readable medium of aspect 2386 wherein the redefined data types comprise enumerable and non-enumerable data types.

2399. The machine-readable medium of aspect 2387 wherein the redefined data types comprise enumerable and non-enumerable data types.

2400. The machine-readable medium of aspect 2388 wherein the redefined data types comprise enumerable and non-enumerable data types.

2401. The machine-readable medium of aspect 2385 wherein the redefined data types comprise enumerable and non-enumerable data types.

2402. The machine-readable medium of aspect 2397 wherein all data elements of the non-enumerated data types are represented as sets.

2403. The machine-readable medium of aspect 2398 wherein all data elements of the non-enumerated data types are represented as sets.

2404. The machine-readable medium of aspect 2399 wherein all data elements of the non-enumerated data types are represented as sets.

2405. The machine-readable medium of aspect 2400 wherein all data elements of the non-enumerated data types are represented as sets.

2406. The machine-readable medium of aspect 2401 wherein all data elements of the non-enumerated data types are represented as sets.

2407. The machine-readable medium of aspect 2402 wherein all data elements consisting of infinite sets are expressed with a finite lexical notation.

2408. The machine-readable medium of aspect 2403 wherein all data elements consisting of infinite sets are expressed with a finite lexical notation.

2409. The machine-readable medium of aspect 2404 wherein all data elements consisting of infinite sets are expressed with a finite lexical notation.

2410. The machine-readable medium of aspect 2405 wherein all data elements consisting of infinite sets are expressed with a finite lexical notation.

2411. The machine-readable medium of aspect 2406 wherein all data elements consisting of infinite sets are expressed with a finite lexical notation.

2412. The machine-readable medium of aspect 2402 wherein numeric data types are non-enumerated data types and numeric data elements of the numeric data types are expressed using equalities and/or inequalities.

2413. The machine-readable medium of aspect 2403 wherein numeric data types are non-enumerated data types and numeric data elements of the numeric data types are expressed using equalities and/or inequalities.

2414. The machine-readable medium of aspect 2404 wherein numeric data types are non-enumerated data types and numeric data elements of the numeric data types are expressed using equalities and/or inequalities.

2415. The machine-readable medium of aspect 2405 wherein numeric data types are non-enumerated data types and numeric data elements of the numeric data types are expressed using equalities and/or inequalities.

2416. The machine-readable medium of aspect 2406 wherein numeric data types are non-enumerated data types and numeric data elements of the numeric data types are expressed using equalities and/or inequalities.

2417. The machine-readable medium of aspect 2382 wherein said verifying compliance with the finite code path property includes demonstrating all possible code paths within the language can be expressed in a finite tree model.

2418. The machine-readable medium of aspect 2417, wherein the tree model comprises a directed acyclic graph.

2419. The machine-readable medium of aspect 2418 wherein said demonstrating all possible code paths within the language includes generating a tree model using a tableau algorithm.

2420. The machine-readable medium of aspect 2417 wherein said demonstrating all possible code paths within the language includes generating a tree model using a tableau algorithm.

2421. The machine-readable medium of aspect 2417 wherein said demonstrating all possible code paths within the language includes generating a tree model using a model search algorithm.

2422. The machine-readable medium of aspect 2383 wherein said further comprising verifying compliance with the finite code path property includes demonstrating all possible code paths within the language can be expressed in a finite tree model.

2423. The machine-readable medium of aspect 2422, wherein the tree model comprises a directed acyclic graph.

2424. The machine-readable medium of aspect 2423 wherein said demonstrating all possible code paths within the language includes generating a tree model using a tableau algorithm.

2425. The machine-readable medium of aspect 2395 wherein said demonstrating all possible code paths within the language includes generating a tree model using a tableau algorithm.

2426. The machine-readable medium of aspect 2395 wherein said demonstrating all possible code paths within the language includes generating a tree model using a model search algorithm.

2427. The machine-readable medium of aspect 2384 wherein said further comprising verifying compliance with the finite code path property includes demonstrating all possible code paths within the language can be expressed in a finite tree model.

2428. The machine-readable medium of aspect 2427, wherein the tree model comprises a directed acyclic graph.

2429. The machine-readable medium of aspect 2428 wherein said demonstrating all possible code paths within the language includes generating a tree model using a tableau algorithm.

2430. The machine-readable medium of aspect 2427 wherein said demonstrating all possible code paths within the language includes generating a tree model using a tableau algorithm.

2431. The machine-readable medium of aspect 2427 wherein said demonstrating all possible code paths within the language includes generating a tree model using a model search algorithm.

2432. The machine-readable medium of aspect 2383, wherein said verifying compliance with the data flow property includes identifying a set of one or more complete and correct algorithms that can determine the value of any data element in the set of all programs written in the language.

2433. The machine-readable medium of aspect 2432 wherein said identifying a set of one or more complete and correct algorithms includes demonstrating a valid algorithm for each data type associated with the language.

2434. The machine-readable medium of aspect 2433, wherein said demonstrating a valid algorithm for each data type includes utilizing automated algebraic analysis.

2435. The machine-readable medium of aspect 2433, wherein said demonstrating a valid algorithm for each data type includes utilizing approximation.

2436. The machine-readable medium of aspect 2387, wherein said verifying compliance with the data flow property includes identifying a set of one or more complete and correct algorithms that can determine the value of any data element in the set of all programs written in the language.

2437. The machine-readable medium of aspect 2436 wherein said identifying a set of one or more complete and correct algorithms includes demonstrating a valid algorithm for each data type associated with the language.

2438. The machine-readable medium of aspect 2437, wherein said demonstrating a valid algorithm for each data type includes utilizing automated algebraic analysis.

2439. The machine-readable medium of aspect 2437, wherein said demonstrating a valid algorithm for each data type includes utilizing approximation.

2440. The machine-readable medium of aspect 2391, wherein said verifying compliance with the data flow property includes identifying a set of one or more complete and correct algorithms that can determine the value of any data element in the set of all programs written in the language.

2441. The machine-readable medium of aspect 2440 wherein said identifying a set of one or more complete and correct algorithms includes demonstrating a valid algorithm for each data type associated with the language.

2442. The machine-readable medium of aspect 2441, wherein said demonstrating a valid algorithm for each data type includes utilizing automated algebraic analysis.

2443. The machine-readable medium of aspect 2441, wherein said demonstrating a valid algorithm for each data type includes utilizing approximation.

2444. The machine-readable medium of aspect 2382, further comprising instructions that, when executed by one or more machines, cause the one or more machines to perform the following: repeating modifying the language after said verifying compliance with the finite code path property if compliance with the finite code path property is unverifiable.

2445. The machine-readable medium of aspect 2444, wherein the operations of modifying and verifying are repeated iteratively until the finite code path property is verified.

2446. The machine-readable medium of aspect 2384, further comprising instructions that, when executed by one or more machines, cause the one or more machines to perform the following: repeating modifying the language after said verifying compliance with the finite code path property if compliance with the finite code path property is unverifiable.

2447. The machine-readable medium of aspect 2446, wherein the operations of modifying and verifying are repeated iteratively until the finite code path property is verified.

2448. The machine-readable medium of aspect 2386, further comprising instructions that, when executed by one or more machines, cause the one or more machines to perform the following: repeating modifying the language after said verifying compliance with the finite code path property if compliance with the finite code path property is unverifiable.

2449. The machine-readable medium of aspect 2448, wherein the operations of modifying and verifying are repeated iteratively until the finite code path property is verified.

2450. The machine-readable medium of aspect 2388, further comprising instructions that, when executed by one or more machines, cause the one or more machines to perform the following: repeating modifying the language after said verifying compliance with the finite code path property if compliance with the finite code path property is unverifiable.

2451. The machine-readable medium of aspect 2450, wherein the operations of modifying and verifying are repeated iteratively until the finite code path property is verified.

2452. The machine-readable medium of aspect 2390, further comprising instructions that, when executed by one or more machines, cause the one or more machines to perform the following: repeating modifying the language after said verifying compliance with the finite code path property if compliance with the finite code path property is unverifiable.

2453. The machine-readable medium of aspect 2452, wherein the operations of modifying and verifying are repeated iteratively until the finite code path property is verified.

2454. The machine-readable medium of aspect 2394, further comprising instructions that, when executed by one or more machines, cause the one or more machines to perform the following: repeating modifying the language after said verifying compliance with the finite code path property if compliance with the finite code path property is unverifiable.

2455. The machine-readable medium of aspect 2454, wherein the operations of modifying and verifying are repeated iteratively until the finite code path property is verified.

2456. The machine-readable medium of aspect 2396, further comprising instructions that, when executed by one or more machines, cause the one or more machines to perform the following: repeating modifying the language after said verifying compliance with the finite code path property if compliance with the finite code path property is unverifiable.

2457. The machine-readable medium of aspect 2456, wherein the operations of modifying and verifying are repeated iteratively until the finite code path property is verified.

2458. The machine-readable medium of aspect 2398, further comprising instructions that, when executed by one or more machines, cause the one or more machines to perform the following: repeating modifying the language after said verifying compliance with the finite code path property if compliance with the finite code path property is unverifiable.

2459. The machine-readable medium of aspect 2458, wherein the operations of modifying and verifying are repeated iteratively until the finite code path property is verified.

2460. The machine-readable medium of aspect 2400, further comprising instructions that, when executed by one or more machines, cause the one or more machines to perform the following: repeating modifying the language after said verifying compliance with the finite code path property if compliance with the finite code path property is unverifiable.

2461. The machine-readable medium of aspect 2460, wherein the operations of modifying and verifying are repeated iteratively until the finite code path property is verified.

2462. The machine-readable medium of aspect 2403, further comprising instructions that, when executed by one or more machines, cause the one or more machines to perform the following: repeating modifying the language after said verifying compliance with the finite code path property if compliance with the finite code path property is unverifiable.

2463. The machine-readable medium of aspect 2462, wherein the operations of modifying and verifying are repeated iteratively until the finite code path property is verified.

2464. The machine-readable medium of aspect 2405, further comprising instructions that, when executed by one or more machines, cause the one or more machines to perform the following: repeating modifying the language after said verifying compliance with the finite code path property if compliance with the finite code path property is unverifiable.

2465. The machine-readable medium of aspect 2464, wherein the operations of modifying and verifying are repeated iteratively until the finite code path property is verified.

2466. The machine-readable medium of aspect 2408, further comprising instructions that, when executed by one or more machines, cause the one or more machines to perform the following: repeating modifying the language after said verifying compliance with the finite code path property if compliance with the finite code path property is unverifiable.

2467. The machine-readable medium of aspect 2466, wherein the operations of modifying and verifying are repeated iteratively until the finite code path property is verified.

2468. The machine-readable medium of aspect 2410, further comprising instructions that, when executed by one or more machines, cause the one or more machines to perform the following: repeating modifying the language after said verifying compliance with the finite code path property if compliance with the finite code path property is unverifiable.

2469. The machine-readable medium of aspect 2468, wherein the operations of modifying and verifying are repeated iteratively until the finite code path property is verified.

2470. The machine-readable medium of aspect 2413, further comprising instructions that, when executed by one or more machines, cause the one or more machines to perform the following: repeating modifying the language after said verifying compliance with the finite code path property if compliance with the finite code path property is unverifiable.

2471. The machine-readable medium of aspect 2470, wherein the operations of modifying and verifying are repeated iteratively until the finite code path property is verified.

2472. The machine-readable medium of aspect 2415, further comprising instructions that, when executed by one or more machines, cause the one or more machines to perform the following: repeating modifying the language after said verifying compliance with the finite code path property if compliance with the finite code path property is unverifiable.

2473. The machine-readable medium of aspect 2472, wherein the operations of modifying and verifying are repeated iteratively until the finite code path property is verified.

2474. The machine-readable medium of aspect 2417, further comprising instructions that, when executed by one or more machines, cause the one or more machines to perform the following: repeating modifying the language after said verifying compliance with the finite code path property if compliance with the finite code path property is unverifiable.

2475. The machine-readable medium of aspect 2474, wherein the operations of modifying and verifying are repeated iteratively until the finite code path property is verified.

2476. The machine-readable medium of aspect 2418, further comprising instructions that, when executed by one or more machines, cause the one or more machines to perform the following: repeating modifying the language after said verifying compliance with the finite code path property if compliance with the finite code path property is unverifiable.

2477. The machine-readable medium of aspect 2476, wherein the operations of modifying and verifying are repeated iteratively until the finite code path property is verified.

2478. The machine-readable medium of aspect 2419, further comprising instructions that, when executed by one or more machines, cause the one or more machines to perform the following: repeating modifying the language after said verifying compliance with the finite code path property if compliance with the finite code path property is unverifiable.

2479. The machine-readable medium of aspect 2478, wherein the operations of modifying and verifying are repeated iteratively until the finite code path property is verified.

2480. The machine-readable medium of aspect 2420, further comprising instructions that, when executed by one or more machines, cause the one or more machines to perform the following: repeating modifying the language after said verifying compliance with the finite code path property if compliance with the finite code path property is unverifiable.

2481. The machine-readable medium of aspect 2480, wherein the operations of modifying and verifying are repeated iteratively until the finite code path property is verified.

2482. The machine-readable medium of aspect 2421, further comprising instructions that, when executed by one or more machines, cause the one or more machines to perform the following: repeating modifying the language after said verifying compliance with the finite code path property if compliance with the finite code path property is unverifiable.

2483. The machine-readable medium of aspect 2482, wherein the operations of modifying and verifying are repeated iteratively until the finite code path property is verified.

2484. The machine-readable medium of aspect 2427, further comprising instructions that, when executed by one or more machines, cause the one or more machines to perform the following: repeating modifying the language after said verifying compliance with the finite code path property if compliance with the finite code path property is unverifiable.

2485. The machine-readable medium of aspect 2484, wherein the operations of modifying and verifying are repeated iteratively until the finite code path property is verified.

2486. The machine-readable medium of aspect 2430, further comprising instructions that, when executed by one or more machines, cause the one or more machines to perform the following: repeating modifying the language after said verifying compliance with the finite code path property if compliance with the finite code path property is unverifiable.

2487. The machine-readable medium of aspect 2486, wherein the operations of modifying and verifying are repeated iteratively until the finite code path property is verified.

2488. The machine-readable medium of aspect 2431, further comprising instructions that, when executed by one or more machines, cause the one or more machines to perform the following: repeating modifying the language after said verifying compliance with the finite code path property if compliance with the finite code path property is unverifiable.

2489. The machine-readable medium of aspect 2488, wherein the operations of modifying and verifying are repeated iteratively until the finite code path property is verified.

2490. A software enterprise system governed by a finite input/output semantic (FIOSM) model.

2491. The software enterprise system of aspect 2490, wherein the software enterprise system does not include operators having ambiguous semantics or operators capable of invoking infinite code paths.

2492. The software enterprise system of aspect 2491, wherein the infinite code paths comprise infinite loops.

2493. The software enterprise system of aspect 2490, further including a plurality of operators wherein not one of the plurality of operators is capable of invoking an infinite code path in the software enterprise system.

2494. The software enterprise system of aspect 2493, wherein the infinite code path comprises an infinite loop.

2495. The software enterprise system of aspect 2490, further including a plurality of operators wherein no combination of operators of the plurality of operators are capable of invoking an infinite code path in the software enterprise system.

2496. The software enterprise system of aspect 2495, wherein the infinite code path comprises an infinite loop.

2497. The software enterprise system of aspect 2490, wherein the software enterprise system is a written in a modified version of a preexisting computer language, the modified version having a decidable and complete data flow.

2498. The software enterprise system of aspect 2497 wherein the existing computer language is one of C, C+, C++, Java, Basic, Pascal, and Fortran.

2499. The software enterprise system of aspect 2490 wherein the software enterprise system is written in a computer language wherein each operator of a set consisting of all operators in the computer language has unambiguous semantics and is incapable of an invoking infinite code path alone or in combination with other operators.

2500. The software enterprise system of aspect 2490 wherein the software enterprise system is written in a computer language wherein all enterprise systems created in the language have a decidable and complete data flow.

2501. The software enterprise system of aspect 2490 wherein the software enterprise system is written in a computer language wherein a finite input output semantic model can be generated for any software enterprise system created in the language.

2502. The software enterprise system of aspect 2490 wherein the software enterprise system is written in a computer language wherein each operator of a set consisting of all operators in the computer language is incapable of an invoking infinite code path alone or in combination with other operators.

2503. The software enterprise system of aspect 2490, comprising at least 1,000 lines of code.

2504. The software enterprise system of aspect 2491, comprising at least 1,000 lines of code.

2505. The software enterprise system of aspect 2492, comprising at least 1,000 lines of code.

2506. The software enterprise system of aspect 2493, comprising at least 1,000 lines of code.

2507. The software enterprise system of aspect 2494, comprising at least 1,000 lines of code.

2508. The software enterprise system of aspect 2495, comprising at least 1,000 lines of code.

2509. The software enterprise system of aspect 2496, comprising at least 1,000 lines of code.

2510. The software enterprise system of aspect 2497, comprising at least 1,000 lines of code.

2511. The software enterprise system of aspect 2498, comprising at least 1,000 lines of code.

2512. The software enterprise system of aspect 2499, comprising at least 1,000 lines of code.

2513. The software enterprise system of aspect 2500, comprising at least 1,000 lines of code.

2514. The software enterprise system of aspect 2501, comprising at least 1,000 lines of code.

2515. The software enterprise system of aspect 2502, comprising at least 1,000 lines of code.

2516. The software enterprise system of aspect 2490, comprising at least 10,000 lines of code.

2517. The software enterprise system of aspect 2491, comprising at least 10,000 lines of code.

2518. The software enterprise system of aspect 2492, comprising at least 10,000 lines of code.

2519. The software enterprise system of aspect 2493, comprising at least 10,000 lines of code.

2520. The software enterprise system of aspect 2494, comprising at least 10,000 lines of code.

2521. The software enterprise system of aspect 2495, comprising at least 10,000 lines of code.

2522. The software enterprise system of aspect 2496, comprising at least 10,000 lines of code.

2523. The software enterprise system of aspect 2497, comprising at least 10,000 lines of code.

2524. The software enterprise system of aspect 2498, comprising at least 10,000 lines of code.

2525. The software enterprise system of aspect 2499, comprising at least 10,000 lines of code.

2526. The software enterprise system of aspect 2500, comprising at least 10,000 lines of code.

2527. The software enterprise system of aspect 2501, comprising at least 10,000 lines of code.

2528. The software enterprise system of aspect 2502, comprising at least 10,000 lines of code.

2529. The software enterprise system of aspect 2490, comprising at least 100,000 lines of code.

2530. The software enterprise system of aspect 2491, comprising at least 100,000 lines of code.

2531. The software enterprise system of aspect 2492, comprising at least 100,000 lines of code.

2532. The software enterprise system of aspect 2493, comprising at least 100,000 lines of code.

2533. The software enterprise system of aspect 2494, comprising at least 100,000 lines of code.

2534. The software enterprise system of aspect 2495, comprising at least 100,000 lines of code.

2535. The software enterprise system of aspect 2496, comprising at least 100,000 lines of code.

2536. The software enterprise system of aspect 2497, comprising at least 100,000 lines of code.

2537. The software enterprise system of aspect 2498, comprising at least 100,000 lines of code.

2538. The software enterprise system of aspect 2499, comprising at least 100,000 lines of code.

2539. The software enterprise system of aspect 2500, comprising at least 100,000 lines of code.

2540. The software enterprise system of aspect 2501, comprising at least 100,000 lines of code.

2541. The software enterprise system of aspect 2502, comprising at least 100,000 lines of code.

2542. The software enterprise system of aspect 2490, comprising at least 1,000,000 lines of code.

2543. The software enterprise system of aspect 2491, comprising at least 1,000,000 lines of code.

2544. The software enterprise system of aspect 2492, comprising at least 1,000,000 lines of code.

2545. The software enterprise system of aspect 2493, comprising at least 1,000,000 lines of code.

2546. The software enterprise system of aspect 2494, comprising at least 1,000,000 lines of code.

2547. The software enterprise system of aspect 2495, comprising at least 1,000,000 lines of code.

2548. The software enterprise system of aspect 2496, comprising at least 1,000,000 lines of code.

2549. The software enterprise system of aspect 2497, comprising at least 1,000,000 lines of code.

2550. The software enterprise system of aspect 2498, comprising at least 1,000,000 lines of code.

2551. The software enterprise system of aspect 2499, comprising at least 1,000,000 lines of code.

2552. The software enterprise system of aspect 2500, comprising at least 1,000,000 lines of code.

2553. The software enterprise system of aspect 2501, comprising at least 1,000,000 lines of code.

2554. The software enterprise system of aspect 2502, comprising at least 1,000,000 lines of code.

2555. A software enterprise system wherein all outputs can be mapped to all inputs.

2556. The software enterprise system of aspect 2555, wherein the software enterprise system does not include operators having ambiguous semantics or operators capable of invoking infinite code paths.

2557. The software enterprise system of aspect 2556, wherein the infinite code paths comprise infinite loops.

2558. The software enterprise system of aspect 2555, further including a plurality of operators wherein not one of the plurality of operators is capable of invoking an infinite code path in the software enterprise system.

2559. The software enterprise system of aspect 2558, wherein the infinite code path comprises an infinite loop.

2560. The software enterprise system of aspect 2555, further including a plurality of operators wherein no combination of operators of the plurality of operators are capable of invoking an infinite code path in the software enterprise system.

2561. The software enterprise system of aspect 2560, wherein the infinite code path comprises an infinite loop.

2562. The software enterprise system of aspect 2555, wherein the software enterprise system is a written in a modified version of an existing computer language.

2563. The software enterprise system of aspect 2562 wherein the existing computer language is one of C, C+, C++, Java, Basic, Pascal, and Fortran.

2564. The software enterprise system of aspect 2555 wherein the software enterprise system is written in a computer language wherein each operator of a set consisting of all operators in the computer language has unambiguous semantics and is incapable of an invoking infinite code path alone or in combination with other operators.

2565. The software enterprise system of aspect 2555 wherein the software enterprise system is written in a computer language wherein all enterprise systems created in the language have a decidable and complete data flow.

2566. The software enterprise system of aspect 2555 wherein the software enterprise system is written in a computer language wherein a finite input output semantic model can be generated for any enterprise system created in the language.

2567. The software enterprise system of aspect 2555 wherein the software enterprise system is written in a computer language wherein each operator of a set consisting of all operators in the computer language is incapable of an invoking infinite code path alone or in combination with other operators.

2568. The software enterprise system of aspect 2555, comprising at least 1,000 lines of code.

2569. The software enterprise system of aspect 2556, comprising at least 1,000 lines of code.

2570. The software enterprise system of aspect 2557, comprising at least 1,000 lines of code.

2571. The software enterprise system of aspect 2558, comprising at least 1,000 lines of code.

2572. The software enterprise system of aspect 2559, comprising at least 1,000 lines of code.

2573. The software enterprise system of aspect 2560, comprising at least 1,000 lines of code.

2574. The software enterprise system of aspect 2561, comprising at least 1,000 lines of code.

2575. The software enterprise system of aspect 2562, comprising at least 1,000 lines of code.

2576. The software enterprise system of aspect 2563, comprising at least 1,000 lines of code.

2577. The software enterprise system of aspect 2564, comprising at least 1,000 lines of code.

2578. The software enterprise system of aspect 2565, comprising at least 1,000 lines of code.

2579. The software enterprise system of aspect 2566, comprising at least 1,000 lines of code.

2580. The software enterprise system of aspect 2567, comprising at least 1,000 lines of code.

2581. The software enterprise system of aspect 2555, comprising at least 10,000 lines of code.

2582. The software enterprise system of aspect 2556, comprising at least 10,000 lines of code.

2583. The software enterprise system of aspect 2557, comprising at least 10,000 lines of code.

2584. The software enterprise system of aspect 2558, comprising at least 10,000 lines of code.

2585. The software enterprise system of aspect 2559, comprising at least 10,000 lines of code.

2586. The software enterprise system of aspect 2560, comprising at least 10,000 lines of code.

2587. The software enterprise system of aspect 2561, comprising at least 10,000 lines of code.

2588. The software enterprise system of aspect 2562, comprising at least 10,000 lines of code.

2589. The software enterprise system of aspect 2563, comprising at least 10,000 lines of code.

2590. The software enterprise system of aspect 2564, comprising at least 10,000 lines of code.

2591. The software enterprise system of aspect 2565, comprising at least 10,000 lines of code.

2592. The software enterprise system of aspect 2566, comprising at least 10,000 lines of code.

2593. The software enterprise system of aspect 2567, comprising at least 10,000 lines of code.

2594. The software enterprise system of aspect 2555, comprising at least 100,000 lines of code.

2595. The software enterprise system of aspect 2556, comprising at least 100,000 lines of code.

2596. The software enterprise system of aspect 2557, comprising at least 100,000 lines of code.

2597. The software enterprise system of aspect 2558, comprising at least 100,000 lines of code.

2598. The software enterprise system of aspect 2559, comprising at least 100,000 lines of code.

2599. The software enterprise system of aspect 2560, comprising at least 100,000 lines of code.

2600. The software enterprise system of aspect 2561, comprising at least 100,000 lines of code.

2601. The software enterprise system of aspect 2562, comprising at least 100,000 lines of code.

2602. The software enterprise system of aspect 2563, comprising at least 100,000 lines of code.

2603. The software enterprise system of aspect 2564, comprising at least 100,000 lines of code.

2604. The software enterprise system of aspect 2565, comprising at least 100,000 lines of code.

2605. The software enterprise system of aspect 2566, comprising at least 100,000 lines of code.

2606. The software enterprise system of aspect 2567, comprising at least 100,000 lines of code.

2607. The software enterprise system of aspect 2555, comprising at least 1,000,000 lines of code.

2608. The software enterprise system of aspect 2556, comprising at least 1,000,000 lines of code.

2609. The software enterprise system of aspect 2557, comprising at least 1,000,000 lines of code.

2610. The software enterprise system of aspect 2558, comprising at least 1,000,000 lines of code.

2611. The software enterprise system of aspect 2559, comprising at least 1,000,000 lines of code.

2612. The software enterprise system of aspect 2560, comprising at least 1,000,000 lines of code.

2613. The software enterprise system of aspect 2561, comprising at least 1,000,000 lines of code.

2614. The software enterprise system of aspect 2562, comprising at least 1,000,000 lines of code.

2615. The software enterprise system of aspect 2563, comprising at least 1,000,000 lines of code.

2616. The software enterprise system of aspect 2564, comprising at least 1,000,000 lines of code.

2617. The software enterprise system of aspect 2565, comprising at least 1,000,000 lines of code.

2618. The software enterprise system of aspect 2566, comprising at least 1,000,000 lines of code.

2619. The software enterprise system of aspect 2567, comprising at least 1,000,000 lines of code.

2620. A software enterprise system having a finite set of input and output patterns.

2621. The software enterprise system of aspect 2620, wherein the software enterprise system does not include control flow operators having ambiguous semantics or control flow operators capable of invoking infinite code paths.

2622. The software enterprise system of aspect 2621, wherein the infinite code paths comprise infinite loops.

2623. The software enterprise system of aspect 2620, further including a plurality of operators wherein not one of the plurality of operators is capable of invoking an infinite code path in the software enterprise system.

2624. The software enterprise system of aspect 2623, wherein the infinite code path comprises an infinite loop.

2625. The software enterprise system of aspect 2620, further including a plurality of operators wherein no combination of operators of the plurality of operators are capable of invoking an infinite code path in the software enterprise system.

2626. The software enterprise system of aspect 2625, wherein the infinite code path comprises an infinite loop.

2627. The software enterprise system of aspect 2620, wherein the software enterprise system is a written in a modified version of an existing computer language.

2628. The software enterprise system of aspect 2627 wherein the existing computer language is one of C, C+, C++, Java, Basic, Pascal, and Fortran.

2629. The software enterprise system of aspect 2620 wherein the software enterprise system is written in a computer language wherein each operator of a set consisting of all operators in the computer language has unambiguous semantics and is incapable of an invoking infinite code path alone or in combination with other operators.

2630. The software enterprise system of aspect 2620 wherein the software enterprise system is written in a computer language wherein all enterprise systems created in the language have a decidable and complete data flow.

2631. The software enterprise system of aspect 2620 wherein the software enterprise system is written in a computer language wherein a finite input output semantic model can be generated for any enterprise system created in the language.

2632. The software enterprise system of aspect 2620 wherein the software enterprise system is written in a computer language wherein each operator of a set consisting of all operators in the computer language is incapable of an invoking infinite code path alone or in combination with other operators.

2633. The software enterprise system of aspect 2620, comprising at least 1,000 lines of code.

2634. The software enterprise system of aspect 2621, comprising at least 1,000 lines of code.

2635. The software enterprise system of aspect 2622, comprising at least 1,000 lines of code.

2636. The software enterprise system of aspect 2623, comprising at least 1,000 lines of code.

2637. The software enterprise system of aspect 2624, comprising at least 1,000 lines of code.

2638. The software enterprise system of aspect 2625, comprising at least 1,000 lines of code.

2639. The software enterprise system of aspect 2626, comprising at least 1,000 lines of code.

2640. The software enterprise system of aspect 2627, comprising at least 1,000 lines of code.

2641. The software enterprise system of aspect 2628, comprising at least 1,000 lines of code.

2642. The software enterprise system of aspect 2629, comprising at least 1,000 lines of code.

2643. The software enterprise system of aspect 2630, comprising at least 1,000 lines of code.

2644. The software enterprise system of aspect 2631, comprising at least 1,000 lines of code.

2645. The software enterprise system of aspect 2632, comprising at least 1,000 lines of code.

2646. The software enterprise system of aspect 2620, comprising at least 10,000 lines of code.

2647. The software enterprise system of aspect 2621, comprising at least 10,000 lines of code.

2648. The software enterprise system of aspect 2622, comprising at least 10,000 lines of code.

2649. The software enterprise system of aspect 2623, comprising at least 10,000 lines of code.

2650. The software enterprise system of aspect 2624, comprising at least 10,000 lines of code.

2651. The software enterprise system of aspect 2625, comprising at least 10,000 lines of code.

2652. The software enterprise system of aspect 2626, comprising at least 10,000 lines of code.

2653. The software enterprise system of aspect 2627, comprising at least 10,000 lines of code.

2654. The software enterprise system of aspect 2628, comprising at least 10,000 lines of code.

2655. The software enterprise system of aspect 2629, comprising at least 10,000 lines of code.

2656. The software enterprise system of aspect 2630, comprising at least 10,000 lines of code.

2657. The software enterprise system of aspect 2631, comprising at least 10,000 lines of code.

2658. The software enterprise system of aspect 2632, comprising at least 10,000 lines of code.

2659. The software enterprise system of aspect 2620, comprising at least 100,000 lines of code.

2660. The software enterprise system of aspect 2621, comprising at least 100,000 lines of code.

2661. The software enterprise system of aspect 2622, comprising at least 100,000 lines of code.

2662. The software enterprise system of aspect 2623, comprising at least 100,000 lines of code.

2663. The software enterprise system of aspect 2624, comprising at least 100,000 lines of code.

2664. The software enterprise system of aspect 2625, comprising at least 100,000 lines of code.

2665. The software enterprise system of aspect 2626, comprising at least 100,000 lines of code.

2666. The software enterprise system of aspect 2627, comprising at least 100,000 lines of code.

2667. The software enterprise system of aspect 2628, comprising at least 100,000 lines of code.

2668. The software enterprise system of aspect 2629, comprising at least 100,000 lines of code.

2669. The software enterprise system of aspect 2630, comprising at least 100,000 lines of code.

2670. The software enterprise system of aspect 2631, comprising at least 100,000 lines of code.

2671. The software enterprise system of aspect 2632, comprising at least 100,000 lines of code.

2672. The software enterprise system of aspect 2620, comprising at least 1,000,000 lines of code.

2673. The software enterprise system of aspect 2621, comprising at least 1,000,000 lines of code.

2674. The software enterprise system of aspect 2622, comprising at least 1,000,000 lines of code.

2675. The software enterprise system of aspect 2623, comprising at least 1,000,000 lines of code.

2676. The software enterprise system of aspect 2624, comprising at least 1,000,000 lines of code.

2677. The software enterprise system of aspect 2625, comprising at least 1,000,000 lines of code.

2678. The software enterprise system of aspect 2626, comprising at least 1,000,000 lines of code.

2679. The software enterprise system of aspect 2627, comprising at least 1,000,000 lines of code.

2680. The software enterprise system of aspect 2628, comprising at least 1,000,000 lines of code.

2681. The software enterprise system of aspect 2629, comprising at least 1,000,000 lines of code.

2682. The software enterprise system of aspect 2630, comprising at least 1,000,000 lines of code.

2683. The software enterprise system of aspect 2631, comprising at least 1,000,000 lines of code.

2684. The software enterprise system of aspect 2632, comprising at least 1,000,000 lines of code.

2685. A software enterprise system having completely decidable data flow.

2686. The software enterprise system of aspect 2685, wherein the software enterprise system does not include operators having ambiguous semantics or operators capable of invoking infinite code paths.

2687. The software enterprise system of aspect 2686, wherein the infinite code paths comprise infinite loops.

2688. The software enterprise system of aspect 2685, further including a plurality of operators wherein not one of the plurality of operators is capable of invoking an infinite code path in the software enterprise system.

2689. The software enterprise system of aspect 2688, wherein the infinite code path comprises an infinite loop.

2690. The software enterprise system of aspect 2685, further including a plurality of operators wherein no combination of operators of the plurality of operators are capable of invoking an infinite code path in the software enterprise system.

2691. The software enterprise system of aspect 2690, wherein the infinite code path comprises an infinite loop.

2692. The software enterprise system of aspect 2685, wherein the software enterprise system is a written in a modified version of an existing computer language.

2693. The software enterprise system of aspect 2692 wherein the existing computer language is one of C, C+, C++, Java, Basic, Pascal, and Fortran.

2694. The software enterprise system of aspect 2685 wherein the software enterprise system is written in a computer language wherein each operator of a set consisting of all operators in the computer language has unambiguous semantics and is incapable of an invoking infinite code path alone or in combination with other operators.

2695. The software enterprise system of aspect 2685 wherein the software enterprise system is written in a computer language wherein all enterprise systems created in the language have a decidable and complete data flow.

2696. The software enterprise system of aspect 2685 wherein the software enterprise system is written in a computer language wherein a finite input output semantic model can be generated for any enterprise system created in the language.

2697. The software enterprise system of aspect 2685 wherein the software enterprise system is written in a computer language wherein each operator of a set consisting of all operators in the computer language is incapable of an invoking infinite code path alone or in combination with other operators.

2698. The software enterprise system of aspect 2685, comprising at least 1,000 lines of code.

2699. The software enterprise system of aspect 2686, comprising at least 1,000 lines of code.

2700. The software enterprise system of aspect 2687, comprising at least 1,000 lines of code.

2701. The software enterprise system of aspect 2688, comprising at least 1,000 lines of code.

2702. The software enterprise system of aspect 2689, comprising at least 1,000 lines of code.

2703. The software enterprise system of aspect 2690, comprising at least 1,000 lines of code.

2704. The software enterprise system of aspect 2691, comprising at least 1,000 lines of code.

2705. The software enterprise system of aspect 2692, comprising at least 1,000 lines of code.

2706. The software enterprise system of aspect 2693, comprising at least 1,000 lines of code.

2707. The software enterprise system of aspect 2694, comprising at least 1,000 lines of code.

2708. The software enterprise system of aspect 2695, comprising at least 1,000 lines of code.

2709. The software enterprise system of aspect 2696, comprising at least 1,000 lines of code.

2710. The software enterprise system of aspect 2697, comprising at least 1,000 lines of code.

2711. The software enterprise system of aspect 2685, comprising at least 10,000 lines of code.

2712. The software enterprise system of aspect 2686, comprising at least 10,000 lines of code.

2713. The software enterprise system of aspect 2687, comprising at least 10,000 lines of code.

2714. The software enterprise system of aspect 2688, comprising at least 10,000 lines of code.

2715. The software enterprise system of aspect 2689, comprising at least 10,000 lines of code.

2716. The software enterprise system of aspect 2690, comprising at least 10,000 lines of code.

2717. The software enterprise system of aspect 2691, comprising at least 10,000 lines of code.

2718. The software enterprise system of aspect 2692, comprising at least 10,000 lines of code.

2719. The software enterprise system of aspect 2693, comprising at least 10,000 lines of code.

2720. The software enterprise system of aspect 2694, comprising at least 10,000 lines of code.

2721. The software enterprise system of aspect 2695, comprising at least 10,000 lines of code.

2722. The software enterprise system of aspect 2696, comprising at least 10,000 lines of code.

2723. The software enterprise system of aspect 2697, comprising at least 10,000 lines of code.

2724. The software enterprise system of aspect 2685, comprising at least 100,000 lines of code.

2725. The software enterprise system of aspect 2686, comprising at least 100,000 lines of code.

2726. The software enterprise system of aspect 2687, comprising at least 100,000 lines of code.

2727. The software enterprise system of aspect 2688, comprising at least 100,000 lines of code.

2728. The software enterprise system of aspect 2689, comprising at least 100,000 lines of code.

2729. The software enterprise system of aspect 2690, comprising at least 100,000 lines of code.

2730. The software enterprise system of aspect 2691, comprising at least 100,000 lines of code.

2731. The software enterprise system of aspect 2692, comprising at least 100,000 lines of code.

2732. The software enterprise system of aspect 2693, comprising at least 100,000 lines of code.

2733. The software enterprise system of aspect 2694, comprising at least 100,000 lines of code.

2734. The software enterprise system of aspect 2695, comprising at least 100,000 lines of code.

2735. The software enterprise system of aspect 2696, comprising at least 100,000 lines of code.

2736. The software enterprise system of aspect 2697, comprising at least 100,000 lines of code.

2737. The software enterprise system of aspect 2685, comprising at least 1,000,000 lines of code.

2738. The software enterprise system of aspect 2686, comprising at least 1,000,000 lines of code.

2739. The software enterprise system of aspect 2687, comprising at least 1,000,000 lines of code.

2740. The software enterprise system of aspect 2688, comprising at least 1,000,000 lines of code.

2741. The software enterprise system of aspect 2689, comprising at least 1,000,000 lines of code.

2742. The software enterprise system of aspect 2690, comprising at least 1,000,000 lines of code.

2743. The software enterprise system of aspect 2691, comprising at least 1,000,000 lines of code.

2744. The software enterprise system of aspect 2692, comprising at least 1,000,000 lines of code.

2745. The software enterprise system of aspect 2693, comprising at least 1,000,000 lines of code.

2746. The software enterprise system of aspect 2694, comprising at least 1,000,000 lines of code.

2747. The software enterprise system of aspect 2695, comprising at least 1,000,000 lines of code.

2748. The software enterprise system of aspect 2696, comprising at least 1,000,000 lines of code.

2749. The software enterprise system of aspect 2697, comprising at least 1,000,000 lines of code.

2750. A software enterprise system embodying the finite code path property.

2751. The software enterprise system of aspect 2750, wherein the software enterprise system does not include operators having ambiguous semantics or operators capable of invoking infinite code paths.

2752. The software enterprise system of aspect 2751, wherein the infinite code paths comprise infinite loops.

2753. The software enterprise system of aspect 2750, further including a plurality of operators wherein not one of the plurality of operators is capable of invoking an infinite code path in the software enterprise system.

2754. The software enterprise system of aspect 2753, wherein the infinite code path comprises an infinite loop.

2755. The software enterprise system of aspect 2750, further including a plurality of operators wherein no combination of operators of the plurality of operators are capable of invoking an infinite code path in the software enterprise system.

2756. The software enterprise system of aspect 2755, wherein the infinite code path comprises an infinite loop.

2757. The software enterprise system of aspect 2750, wherein the software enterprise system is a written in a modified version of an existing computer language.

2758. The software enterprise system of aspect 2757 wherein the existing computer language is one of C, C+, C++, Java, Basic, Pascal, and Fortran.

2759. The software enterprise system of aspect 2750 wherein the software enterprise system is written in a computer language wherein each operator of a set consisting of all operators in the computer language has unambiguous semantics and is incapable of an invoking infinite code path alone or in combination with other operators.

2760. The software enterprise system of aspect 2750 wherein the software enterprise system is written in a computer language wherein all enterprise systems created in the language have a decidable and complete data flow.

2761. The software enterprise system of aspect 2750 wherein the software enterprise system is written in a computer language wherein a finite input output semantic model can be generated for any enterprise system created in the language.

2762. The software enterprise system of aspect 2750 wherein the software enterprise system is written in a computer language wherein each operator of a set consisting of all operators in the computer language is incapable of an invoking infinite code path alone or in combination with other operators.

2763. The software enterprise system of aspect 2750, comprising at least 1,000 lines of code.

2764. The software enterprise system of aspect 2751, comprising at least 1,000 lines of code.

2765. The software enterprise system of aspect 2752, comprising at least 1,000 lines of code.

2766. The software enterprise system of aspect 2753, comprising at least 1,000 lines of code.

2767. The software enterprise system of aspect 2754, comprising at least 1,000 lines of code.

2768. The software enterprise system of aspect 2755, comprising at least 1,000 lines of code.

2769. The software enterprise system of aspect 2756, comprising at least 1,000 lines of code.

2770. The software enterprise system of aspect 2757, comprising at least 1,000 lines of code.

2771. The software enterprise system of aspect 2758, comprising at least 1,000 lines of code.

2772. The software enterprise system of aspect 2759, comprising at least 1,000 lines of code.

2773. The software enterprise system of aspect 2760, comprising at least 1,000 lines of code.

2774. The software enterprise system of aspect 2761, comprising at least 1,000 lines of code.

2775. The software enterprise system of aspect 2762, comprising at least 1,000 lines of code.

2776. The software enterprise system of aspect 2750, comprising at least 10,000 lines of code.

2777. The software enterprise system of aspect 2751, comprising at least 10,000 lines of code.

2778. The software enterprise system of aspect 2752, comprising at least 10,000 lines of code.

2779. The software enterprise system of aspect 2753, comprising at least 10,000 lines of code.

2780. The software enterprise system of aspect 2754, comprising at least 10,000 lines of code.

2781. The software enterprise system of aspect 2755, comprising at least 10,000 lines of code.

2782. The software enterprise system of aspect 2756, comprising at least 10,000 lines of code.

2783. The software enterprise system of aspect 2757, comprising at least 10,000 lines of code.

2784. The software enterprise system of aspect 2758, comprising at least 10,000 lines of code.

2785. The software enterprise system of aspect 2759, comprising at least 10,000 lines of code.

2786. The software enterprise system of aspect 2760, comprising at least 10,000 lines of code.

2787. The software enterprise system of aspect 2761, comprising at least 10,000 lines of code.

2788. The software enterprise system of aspect 2762, comprising at least 10,000 lines of code.

2789. The software enterprise system of aspect 2750, comprising at least 100,000 lines of code.

2790. The software enterprise system of aspect 2751, comprising at least 100,000 lines of code.

2791. The software enterprise system of aspect 2752, comprising at least 100,000 lines of code.

2792. The software enterprise system of aspect 2753, comprising at least 100,000 lines of code.

2793. The software enterprise system of aspect 2754, comprising at least 100,000 lines of code.

2794. The software enterprise system of aspect 2755, comprising at least 100,000 lines of code.

2795. The software enterprise system of aspect 2756, comprising at least 100,000 lines of code.

2796. The software enterprise system of aspect 2757, comprising at least 100,000 lines of code.

2797. The software enterprise system of aspect 2758, comprising at least 100,000 lines of code.

2798. The software enterprise system of aspect 2759, comprising at least 100,000 lines of code.

2799. The software enterprise system of aspect 2760, comprising at least 100,000 lines of code.

2800. The software enterprise system of aspect 2761, comprising at least 100,000 lines of code.

2801. The software enterprise system of aspect 2762, comprising at least 100,000 lines of code.

2802. The software enterprise system of aspect 2750, comprising at least 1,000,000 lines of code.

2803. The software enterprise system of aspect 2751, comprising at least 1,000,000 lines of code.

2804. The software enterprise system of aspect 2752, comprising at least 1,000,000 lines of code.

2805. The software enterprise system of aspect 2753, comprising at least 1,000,000 lines of code.

2806. The software enterprise system of aspect 2754, comprising at least 1,000,000 lines of code.

2807. The software enterprise system of aspect 2755, comprising at least 1,000,000 lines of code.

2808. The software enterprise system of aspect 2756, comprising at least 1,000,000 lines of code.

2809. The software enterprise system of aspect 2757, comprising at least 1,000,000 lines of code.

2810. The software enterprise system of aspect 2758, comprising at least 1,000,000 lines of code.

2811. The software enterprise system of aspect 2759, comprising at least 1,000,000 lines of code.

2812. The software enterprise system of aspect 2760, comprising at least 1,000,000 lines of code.

2813. The software enterprise system of aspect 2761, comprising at least 1,000,000 lines of code.

2814. The software enterprise system of aspect 2762, comprising at least 1,000,000 lines of code.

2815. A software enterprise system compatible with a finite input output model (FIOSM).

2816. The software enterprise system of aspect 2815, wherein the software enterprise system does not include control flow operators having ambiguous semantics or control flow operators capable of invoking infinite code paths.

2817. The software enterprise system of aspect 2816, wherein the infinite code paths comprise infinite loops.

2818. The software enterprise system of aspect 2815, further including a plurality of operators wherein not one of the plurality of operators is capable of invoking an infinite code path in the software enterprise system.

2819. The software enterprise system of aspect 2818, wherein the infinite code path comprises an infinite loop.

2820. The software enterprise system of aspect 2815, further including a plurality of operators wherein no combination of operators of the plurality of operators are capable of invoking an infinite code path in the software enterprise system.

2821. The software enterprise system of aspect 2820, wherein the infinite code path comprises an infinite loop.

2822. The software enterprise system of aspect 2815, wherein the software enterprise system is a written in a modified version of an existing computer language.

2823. The software enterprise system of aspect 2822 wherein the existing computer language is one of C, C+, C++, Java, Basic, Pascal, and Fortran.

2824. The software enterprise system of aspect 2815 wherein the software enterprise system is written in a computer language wherein each operator of a set consisting of all operators in the computer language has unambiguous semantics and is incapable of an invoking infinite code path alone or in combination with other operators.

2825. The software enterprise system of aspect 2815 wherein the software enterprise system is written in a computer language wherein all enterprise systems created in the language have a decidable and complete data flow.

2826. The software enterprise system of aspect 2815 wherein the software enterprise system is written in a computer language wherein a finite input output semantic model can be generated for any enterprise system created in the language.

2827. The software enterprise system of aspect 2815 wherein the software enterprise system is written in a computer language wherein each operator of a set consisting of all operators in the computer language is incapable of an invoking infinite code path alone or in combination with other operators.

2828. The software enterprise system of aspect 2815, comprising at least 1,000 lines of code.

2829. The software enterprise system of aspect 2816, comprising at least 1,000 lines of code.

2830. The software enterprise system of aspect 2817, comprising at least 1,000 lines of code.

2831. The software enterprise system of aspect 2818, comprising at least 1,000 lines of code.

2832. The software enterprise system of aspect 2819, comprising at least 1,000 lines of code.

2833. The software enterprise system of aspect 2820, comprising at least 1,000 lines of code.

2834. The software enterprise system of aspect 2821, comprising at least 1,000 lines of code.

2835. The software enterprise system of aspect 2822, comprising at least 1,000 lines of code.

2836. The software enterprise system of aspect 2823, comprising at least 1,000 lines of code.

2837. The software enterprise system of aspect 2824, comprising at least 1,000 lines of code.

2838. The software enterprise system of aspect 2825, comprising at least 1,000 lines of code.

2839. The software enterprise system of aspect 2826, comprising at least 1,000 lines of code.

2840. The software enterprise system of aspect 2827, comprising at least 1,000 lines of code.

2841. The software enterprise system of aspect 2815, comprising at least 10,000 lines of code.

2842. The software enterprise system of aspect 2816, comprising at least 10,000 lines of code.

2843. The software enterprise system of aspect 2817, comprising at least 10,000 lines of code.

2844. The software enterprise system of aspect 2818, comprising at least 10,000 lines of code.

2845. The software enterprise system of aspect 2819, comprising at least 10,000 lines of code.

2846. The software enterprise system of aspect 2820, comprising at least 10,000 lines of code.

2847. The software enterprise system of aspect 2821, comprising at least 10,000 lines of code.

2848. The software enterprise system of aspect 2822, comprising at least 10,000 lines of code.

2849. The software enterprise system of aspect 2823, comprising at least 10,000 lines of code.

2850. The software enterprise system of aspect 2824, comprising at least 10,000 lines of code.

2851. The software enterprise system of aspect 2825, comprising at least 10,000 lines of code.

2852. The software enterprise system of aspect 2826, comprising at least 10,000 lines of code.

2853. The software enterprise system of aspect 2827, comprising at least 10,000 lines of code.

2854. The software enterprise system of aspect 2815, comprising at least 100,000 lines of code.

2855. The software enterprise system of aspect 2816, comprising at least 100,000 lines of code.

2856. The software enterprise system of aspect 2817, comprising at least 100,000 lines of code.

2857. The software enterprise system of aspect 2818, comprising at least 100,000 lines of code.

2858. The software enterprise system of aspect 2819, comprising at least 100,000 lines of code.

2859. The software enterprise system of aspect 2820, comprising at least 100,000 lines of code.

2860. The software enterprise system of aspect 2821, comprising at least 100,000 lines of code.

2861. The software enterprise system of aspect 2822, comprising at least 100,000 lines of code.

2862. The software enterprise system of aspect 2823, comprising at least 100,000 lines of code.

2863. The software enterprise system of aspect 2824, comprising at least 100,000 lines of code.

2864. The software enterprise system of aspect 2825, comprising at least 100,000 lines of code.

2865. The software enterprise system of aspect 2826, comprising at least 100,000 lines of code.

2866. The software enterprise system of aspect 2827, comprising at least 100,000 lines of code.

2867. The software enterprise system of aspect 2815, comprising at least 1,000,000 lines of code.

2868. The software enterprise system of aspect 2816, comprising at least 1,000,000 lines of code.

2869. The software enterprise system of aspect 2817, comprising at least 1,000,000 lines of code.

2870. The software enterprise system of aspect 2818, comprising at least 1,000,000 lines of code.

2871. The software enterprise system of aspect 2819, comprising at least 1,000,000 lines of code.

2872. The software enterprise system of aspect 2820, comprising at least 1,000,000 lines of code.

2873. The software enterprise system of aspect 2821, comprising at least 1,000,000 lines of code.

2874. The software enterprise system of aspect 2822, comprising at least 1,000,000 lines of code.

2875. The software enterprise system of aspect 2823, comprising at least 1,000,000 lines of code.

2876. The software enterprise system of aspect 2824, comprising at least 1,000,000 lines of code.

2877. The software enterprise system of aspect 2825, comprising at least 1,000,000 lines of code.

2878. The software enterprise system of aspect 2826, comprising at least 1,000,000 lines of code.

2879. The software enterprise system of aspect 2827, comprising at least 1,000,000 lines of code.

2880. A software enterprise system wherein a finite input output model (FIOSM) can be generated for the software enterprise system.

2881. The software enterprise system of aspect 2880, wherein the software enterprise system does not include operators having ambiguous semantics or operators capable of invoking infinite code paths.

2882. The software enterprise system of aspect 2881, wherein the infinite code paths comprise infinite loops.

2883. The software enterprise system of aspect 2880, further including a plurality of operators wherein not one of the plurality of operators is capable of invoking an infinite code path in the software enterprise system.

2884. The software enterprise system of aspect 2883, wherein the infinite code path comprises an infinite loop.

2885. The software enterprise system of aspect 2880, further including a plurality of operators wherein no combination of operators of the plurality of operators are capable of invoking an infinite code path in the software enterprise system.

2886. The software enterprise system of aspect 2885, wherein the infinite code path comprises an infinite loop.

2887. The software enterprise system of aspect 2880, wherein the software enterprise system is a written in a modified version of an existing computer language.

2888. The software enterprise system of aspect 2887 wherein the existing computer language is one of C, C+, C++, Java, Basic, Pascal, and Fortran.

2889. The software enterprise system of aspect 2880 wherein the software enterprise system is written in a computer language wherein each operator of a set consisting of all operators in the computer language has unambiguous semantics and is incapable of an invoking infinite code path alone or in combination with other operators.

2890. The software enterprise system of aspect 2880 wherein the software enterprise system is written in a computer language wherein all enterprise systems created in the language have a decidable and complete data flow.

2891. The software enterprise system of aspect 2880 wherein the software enterprise system is written in a computer language wherein a FIOSM can be generated for any enterprise system created in the language.

2892. The software enterprise system of aspect 2880 wherein the software enterprise system is written in a computer language wherein each operator of a set consisting of all operators in the computer language is incapable of an invoking infinite code path alone or in combination with other operators.

2893. A software enterprise system comprising at least 1,000 lines of code wherein a finite input output model (FIOSM) can be generated for the software enterprise system.

2894. The software enterprise system of aspect 2893, wherein the software enterprise system does not include operators having ambiguous semantics or operators capable of invoking infinite code paths.

2895. The software enterprise system of aspect 2894, wherein the infinite code paths comprise infinite loops.

2896. The software enterprise system of aspect 2893, further including a plurality of operators wherein not one of the plurality of operators is capable of invoking an infinite code path in the software enterprise system.

2897. The software enterprise system of aspect 2896, wherein the infinite code path comprises an infinite loop.

2898. The software enterprise system of aspect 2893, further including a plurality of operators wherein no combination of operators of the plurality of operators are capable of invoking an infinite code path in the software enterprise system.

2899. The software enterprise system of aspect 2898, wherein the infinite code path comprises an infinite loop.

2900. The software enterprise system of aspect 2893, wherein the software enterprise system is a written in a modified version of an existing computer language.

2901. The software enterprise system of aspect 2900 wherein the existing computer language is one of C, C+, C++, Java, Basic, Pascal, and Fortran.

2902. The software enterprise system of aspect 2893 wherein the software enterprise system is written in a computer language wherein each operator of a set consisting of all operators in the computer language has unambiguous semantics and is incapable of an invoking infinite code path alone or in combination with other operators.

2903. The software enterprise system of aspect 2893 wherein the software enterprise system is written in a computer language wherein all enterprise systems created in the language have a decidable and complete data flow.

2904. The software enterprise system of aspect 2893 wherein the software enterprise system is written in a computer language wherein a FIOSM can be generated for any enterprise system created in the language.

2905. The software enterprise system of aspect 2893 wherein the software enterprise system is written in a computer language wherein each operator of a set consisting of all operators in the computer language is incapable of an invoking infinite code path alone or in combination with other operators.

2906. A software enterprise system comprising at least 10,000 lines of code wherein a finite input output model (FIOSM) can be generated for the software enterprise system.

2907. The software enterprise system of aspect 2906, wherein the software enterprise system does not include operators having ambiguous semantics or operators capable of invoking infinite code paths.

2908. The software enterprise system of aspect 2907, wherein the infinite code paths comprise infinite loops.

2909. The software enterprise system of aspect 2906, further including a plurality of operators wherein not one of the plurality of operators is capable of invoking an infinite code path in the software enterprise system.

2910. The software enterprise system of aspect 2909, wherein the infinite code path comprises an infinite loop.

2911. The software enterprise system of aspect 2906, further including a plurality of operators wherein no combination of operators of the plurality of operators are capable of invoking an infinite code path in the software enterprise system.

2912. The software enterprise system of aspect 2911, wherein the infinite code path comprises an infinite loop.

2913. The software enterprise system of aspect 2906, wherein the software enterprise system is a written in a modified version of an existing computer language.

2914. The software enterprise system of aspect 2913 wherein the existing computer language is one of C, C+, C++, Java, Basic, Pascal, and Fortran.

2915. The software enterprise system of aspect 2906 wherein the software enterprise system is written in a computer language wherein each operator of a set consisting of all operators in the computer language has unambiguous semantics and is incapable of an invoking infinite code path alone or in combination with other operators.

2916. The software enterprise system of aspect 2906 wherein the software enterprise system is written in a computer language wherein all enterprise systems created in the language have a decidable and complete data flow.

2917. The software enterprise system of aspect 2906 wherein the software enterprise system is written in a computer language wherein a FIOSM can be generated for any enterprise system created in the language.

2918. The software enterprise system of aspect 2906 wherein the software enterprise system is written in a computer language wherein each operator of a set consisting of all operators in the computer language is incapable of an invoking infinite code path alone or in combination with other operators.

2919. A software enterprise system comprising at least 100,000 lines of code wherein a finite input output model (FIOSM) can be generated for the software enterprise system.

2920. The software enterprise system of aspect 2919, wherein the software enterprise system does not include operators having ambiguous semantics or operators capable of invoking infinite code paths.

2921. The software enterprise system of aspect 2920, wherein the infinite code paths comprise infinite loops.

2922. The software enterprise system of aspect 2919, further including a plurality of operators wherein not one of the plurality of operators is capable of invoking an infinite code path in the software enterprise system.

2923. The software enterprise system of aspect 2922, wherein the infinite code path comprises an infinite loop.

2924. The software enterprise system of aspect 2919, further including a plurality of operators wherein no combination of operators of the plurality of operators are capable of invoking an infinite code path in the software enterprise system.

2925. The software enterprise system of aspect 2924, wherein the infinite code path comprises an infinite loop.

2926. The software enterprise system of aspect 2919, wherein the software enterprise system is a written in a modified version of an existing computer language.

2927. The software enterprise system of aspect 2926 wherein the existing computer language is one of C, C+, C++, Java, Basic, Pascal, and Fortran.

2928. The software enterprise system of aspect 2919 wherein the software enterprise system is written in a computer language wherein each operator of a set consisting of all operators in the computer language has unambiguous semantics and is incapable of an invoking infinite code path alone or in combination with other operators.

2929. The software enterprise system of aspect 2919 wherein the software enterprise system is written in a computer language wherein all enterprise systems created in the language have a decidable and complete data flow.

2930. The software enterprise system of aspect 2919 wherein the software enterprise system is written in a computer language wherein a FIOSM can be generated for any enterprise system created in the language.

2931. The software enterprise system of aspect 2919 wherein the software enterprise system is written in a computer language wherein each operator of a set consisting of all operators in the computer language is incapable of an invoking infinite code path alone or in combination with other operators.

2932. A software enterprise system comprising at least 1,000,000 lines of code wherein a finite input output model (FIOSM) can be generated for the software enterprise system.

2933. The software enterprise system of aspect 2932, wherein the software enterprise system does not include operators having ambiguous semantics or operators capable of invoking infinite code paths.

2934. The software enterprise system of aspect 2933, wherein the infinite code paths comprise infinite loops.

2935. The software enterprise system of aspect 2932, further including a plurality of operators wherein not one of the plurality of operators is capable of invoking an infinite code path in the software enterprise system.

2936. The software enterprise system of aspect 2935, wherein the infinite code path comprises an infinite loop.

2937. The software enterprise system of aspect 2932, further including a plurality of operators wherein no combination of operators of the plurality of operators are capable of invoking an infinite code path in the software enterprise system.

2938. The software enterprise system of aspect 2937, wherein the infinite code path comprises an infinite loop.

2939. The software enterprise system of aspect 2932, wherein the software enterprise system is a written in a modified version of an existing computer language.

2940. The software enterprise system of aspect 2939 wherein the existing computer language is one of C, C+, C++, Java, Basic, Pascal, and Fortran.

2941. The software enterprise system of aspect 2932 wherein the software enterprise system is written in a computer language wherein each operator of a set consisting of all operators in the computer language has unambiguous semantics and is incapable of an invoking infinite code path alone or in combination with other operators.

2942. The software enterprise system of aspect 2932 wherein the software enterprise system is written in a computer language wherein all enterprise systems created in the language have a decidable and complete data flow.

2943. The software enterprise system of aspect 2932 wherein the software enterprise system is written in a computer language wherein a FIOSM can be generated for any enterprise system created in the language.

2944. The software enterprise system of aspect 2932 wherein the software enterprise system is written in a computer language wherein each operator of a set consisting of all operators in the computer language is incapable of an invoking infinite code path alone or in combination with other operators.

2945. A computer language wherein a finite input output model (FIOSM) can be generated for all programs created in the language.

2946. The computer language of aspect 2945, wherein the computer language does not include operators having ambiguous semantics or operators capable of invoking infinite code paths.

2947. The computer language of aspect 2946, wherein the infinite code paths comprise infinite loops.

2948. The computer language of aspect 2945, further including a plurality of operators wherein not one of the plurality of operators is capable of invoking an infinite code path in any of the set of all programs written in the computer language.

2949. The computer language of aspect 2948, wherein the infinite code path comprises an infinite loop.

2950. The computer language of aspect 2945, further including a plurality of operators wherein no combination of operators of the plurality of operators are capable of invoking an infinite loop in any of the set of all programs written in the computer language.

2951. The computer language of aspect 2950, wherein the infinite code path comprises an infinite loop.

2952. The computer language of aspect 2945, wherein the computer language is a modified version of an existing language.

2953. The computer language of aspect 2952 wherein the existing language is one of C, C+, C++, Java, Basic, Pascal, and Fortran.

2954. The computer language of aspect 2945, wherein all programs comprise commercially useful programs having at least 1,000 lines of code.

2955. The computer language of aspect 2945, wherein all programs having at least 1,000 lines of code.

2956. The computer language of aspect 2945, wherein all programs comprise commercially useful programs having at least 10,000 lines of code.

2957. The computer language of aspect 2945, wherein all programs comprise programs having at least 10,000 lines of code.

2958. The computer language of aspect 2945, wherein all programs comprise commercially useful programs having at least 100,000 lines of code.

2959. The computer language of aspect 2945, wherein all programs comprise programs having at least 100,000 lines of code.

2960. The computer language of aspect 2945, wherein all programs comprise commercially useful programs having at least 1,000,000 lines of code.

2961. The computer language of aspect 2945, wherein all programs comprise programs having at least 1,000,000 lines of code.

2962. A method of creating the computer language of aspect 2945 comprising: modifying an existing language by removing all operators of the language capable of invoking infinite code paths.

2963. A method of creating the computer language of aspect 2945 comprising: modifying an existing language by removing all operators (i) having ambiguous semantics and (ii) being capable of invoking infinite code paths.

2964. The method of aspect 2962, wherein the existing language is one of C, C+, C++, Java, Basic, Pascal, and Fortran.

2965. The method of aspect 2963, wherein the existing language is one of C, C+, C++, Java, Basic, Pascal, and Fortran.

2966. The method of aspect 2962, further comprising replacing the removed operators with one or more alternative operators incapable of invoking or ambiguous infinite loops.

2967. The method of aspect 2963, further comprising replacing the removed operators with one or more alternative operators incapable of invoking or ambiguous infinite loops.

2968. The method of aspect 2967 wherein a for loop operator is replaced with “sum” operator.

2969. A method of creating the computer language of aspect 2945 comprising modifying an existing computer language.

2970. The method of aspect 2969 wherein said modifying an existing an existing computer language comprises replacing operators capable of invoking infinite code paths with operators incapable of invoking infinite code paths.

2971. The method of aspect 2969 wherein said modifying an existing an existing computer language comprises replacing ambiguous operators with unambiguous operators.

2972. The method of aspect 2969 wherein said modifying an existing an existing computer language comprises replacing operators with ambiguous semantics with operators with unambiguous semantics.

2973. The method of aspect 2969, wherein said modifying an existing an existing computer language comprises redefining one or more data types.

2974. The method of aspect 2969, wherein said modifying an existing an existing computer language comprises replacing one or more data types.

2975. The method of aspect 2970, wherein said modifying an existing an existing computer language comprises redefining one or more data types.

2976. The method of aspect 2970, wherein said modifying an existing an existing computer language comprises replacing one or more data types.

2977. The method of aspect 2971, wherein said modifying an existing an existing computer language comprises redefining one or more data types.

2978. The method of aspect 2971, wherein said modifying an existing an existing computer language comprises replacing one or more data types.

2979. The method of aspect 2972, wherein said modifying an existing an existing computer language comprises redefining one or more data types.

2980. The method of aspect 2972, wherein said modifying an existing an existing computer language comprises replacing one or more data types.

2981. The method of creating the computer language of aspect 2969 further comprising verifying the decidable and complete data flow.

2982. The method of creating the computer language of aspect 2970 further comprising verifying the decidable and complete data flow.

2983. The method of creating the computer language of aspect 2971 further comprising verifying the decidable and complete data flow.

2984. The method of creating the computer language of aspect 2972 further comprising verifying the decidable and complete data flow.

2985. The method of creating the computer language of aspect 2973 further comprising verifying the decidable and complete data flow.

2986. The method of creating the computer language of aspect 2974 further comprising verifying the decidable and complete data flow.

2987. The method of creating the computer language of aspect 2975 further comprising verifying the decidable and complete data flow.

2988. The method of creating the computer language of aspect 2976 further comprising verifying the decidable and complete data flow.

2989. The method of creating the computer language of aspect 2977 further comprising verifying the decidable and complete data flow.

2990. The method of creating the computer language of aspect 2978 further comprising verifying the decidable and complete data flow.

2991. The method of creating the computer language of aspect 2979 further comprising verifying the decidable and complete data flow.

2992. The method of creating the computer language of aspect 2980 further comprising verifying the decidable and complete data flow.

2993. A method of creating the computer language of aspect 2945 comprising:
designing the language including defining operators and defining data types; and
verifying an FIOSM can be generated for all programs created in the language by verifying all programs have decidable and complete data flow.

2994. The method of aspect 2993 wherein defining operators includes only specifying operators whose semantics are not ambiguous or cannot invoke infinite code paths.

2995. The method of aspect 2993 wherein the data types comprise enumerable and non-enumerable data types.

2996. The method of aspect 2995 wherein all data elements of the non-enumerated data types are represented as sets.

2997. The method of aspect 2996 wherein all data elements consisting of infinite sets are expressed with a finite lexical notation.

2998. The method of aspect 2996 wherein numeric data types are non-enumerated data types and numeric data elements of the numeric data types are expressed using equalities and/or inequalities.

2999. The method of aspect 2993 wherein verifying decidable and complete data flow comprises verifying both a code path quality and a data flow quality of the language.

3000. The method of aspect 2999 wherein said verifying a code path quality comprises demonstrating all possible code paths within the language can be expressed in a finite tree model.

3001. The method of aspect 3000, wherein the tree model comprises a directed acyclic graph.

3002. The method of aspect 3000 wherein said demonstrating all possible code paths within the language comprises generating a tree model using a tableau algorithm.

3003. The method of aspect 2999, wherein verifying the data flow quality further comprises identifying a set of one or more complete and correct algorithms that can determine the value of any data element in the set of all programs written in the language.

3004. The method of aspect 3003 wherein said identifying a set of one or more complete and correct algorithms comprises demonstrating a valid algorithm for each data type associated with the language.

3005. The method of aspect 3004, wherein said demonstrating a valid algorithm for each data type comprises utilizing automated algebraic analysis.

3006. The method of aspect 3004, wherein said demonstrating a valid algorithm for each data type comprises utilizing approximation.

3007. The method of aspect 2993, further comprising: repeating said designing the language after said verifying the decidable and complete data flow if decidable and complete data flow is unverifiable.

3008. The method of aspect 3007, wherein the operations of designing and verifying are repeated iteratively until decidable and complete data flow is verified.

3009. The method of aspect 2993 wherein defining operators includes only specifying operators whose semantics are not ambiguous or result in infinite code paths.

3010. A computer language wherein a finite input output model (FIOSM) can be generated for all software enterprise systems created in the language.

3011. The computer language of aspect 3010, wherein the computer language does not include operators having ambiguous semantics or operators capable of invoking infinite code paths.

3012. The computer language of aspect 3011, wherein the infinite code paths comprise infinite loops.

3013. The computer language of aspect 3010, further including a plurality of operators wherein not one of the plurality of operators is capable of invoking an infinite code path in any of the set of all software enterprise systems written in the computer language.

3014. The computer language of aspect 3013, wherein the infinite code path comprises an infinite loop.

3015. The computer language of aspect 3010, further including a plurality of operators wherein no combination of operators of the plurality of operators are capable of invoking an infinite loop in any of the set of all software enterprise systems written in the computer language.

3016. The computer language of aspect 3015, wherein the infinite code path comprises an infinite loop.

3017. The computer language of aspect 3010, wherein the computer language is a modified version of an existing language.

3018. The computer language of aspect 3017 wherein the existing language is one of C, C+, C++, Java, Basic, Pascal, and Fortran.

3019. The computer language of aspect 3010, wherein all software enterprise systems comprise commercially useful software enterprise systems having at least 10,000 lines of code.

3020. The computer language of aspect 3010, wherein all software enterprise systems having at least 10,000 lines of code.

3021. The computer language of aspect 3010, wherein all software enterprise systems comprise commercially useful software enterprise systems having at least 100,000 lines of code.

3022. The computer language of aspect 3010, wherein all software enterprise systems comprise software enterprise systems having at least 100,000 lines of code.

3023. The computer language of aspect 3010, wherein all software enterprise systems comprise commercially useful software enterprise systems having at least 1,000,000 lines of code.

3024. The computer language of aspect 3010, wherein all software enterprise systems comprise software enterprise systems having at least 1,000,000 lines of code.

3025. The computer language of aspect 3010, wherein all software enterprise systems comprise commercially useful software enterprise systems having at least 10,000,000 lines of code.

3026. The computer language of aspect 3010, wherein all software enterprise systems comprise software enterprise systems having at least 10,000,000 lines of code.

3027. A method of creating the computer language of aspect 3010 comprising: modifying an existing language by removing all operators of the language capable of invoking infinite code paths.

3028. A method of creating the computer language of aspect 3010 comprising: modifying an existing language by removing all operators (i) having ambiguous semantics and (ii) being capable of invoking infinite code paths.

3029. The method of aspect 3027, wherein the existing language is one of C, C+, C++, Java, Basic, Pascal, and Fortran.

3030. The method of aspect 3028, wherein the existing language is one of C, C+, C++, Java, Basic, Pascal, and Fortran.

3031. The method of aspect 3027, further comprising replacing the removed operators with one or more alternative operators incapable of invoking or ambiguous infinite loops.

3032. The method of aspect 3028, further comprising replacing the removed operators with one or more alternative operators incapable of invoking or ambiguous infinite loops.

3033. The method of aspect 3032 wherein a for loop operator is replaced with “sum” operator.

3034. A method of creating the computer language of aspect 3010 comprising modifying an existing computer language.

3035. The method of aspect 3034 wherein said modifying an existing an existing computer language comprises replacing operators capable of invoking infinite code paths with operators incapable of invoking infinite code paths.

3036. The method of aspect 3034 wherein said modifying an existing an existing computer language comprises replacing ambiguous operators with unambiguous operators.

3037. The method of aspect 3034 wherein said modifying an existing an existing computer language comprises replacing operators with ambiguous semantics with operators with unambiguous semantics.

3038. The method of aspect 3034, wherein said modifying an existing an existing computer language comprises redefining one or more data types.

3039. The method of aspect 3034, wherein said modifying an existing an existing computer language comprises replacing one or more data types.

3040. The method of aspect 3035, wherein said modifying an existing an existing computer language comprises redefining one or more data types.

3041. The method of aspect 3035, wherein said modifying an existing an existing computer language comprises replacing one or more data types.

3042. The method of aspect 3036, wherein said modifying an existing an existing computer language comprises redefining one or more data types.

3043. The method of aspect 3036, wherein said modifying an existing an existing computer language comprises replacing one or more data types.

3044. The method of aspect 3037, wherein said modifying an existing an existing computer language comprises redefining one or more data types.

3045. The method of aspect 3037, wherein said modifying an existing an existing computer language comprises replacing one or more data types.

3046. The method of creating the computer language of aspect 3034 further comprising verifying the decidable and complete data flow.

3047. The method of creating the computer language of aspect 3035 further comprising verifying the decidable and complete data flow.

3048. The method of creating the computer language of aspect 3036 further comprising verifying the decidable and complete data flow.

3049. The method of creating the computer language of aspect 3037 further comprising verifying the decidable and complete data flow.

3050. The method of creating the computer language of aspect 3038 further comprising verifying the decidable and complete data flow.

3051. The method of creating the computer language of aspect 3039 further comprising verifying the decidable and complete data flow.

3052. The method of creating the computer language of aspect 3040 further comprising verifying the decidable and complete data flow.

3053. The method of creating the computer language of aspect 3041 further comprising verifying the decidable and complete data flow.

3054. The method of creating the computer language of aspect 3042 further comprising verifying the decidable and complete data flow.

3055. The method of creating the computer language of aspect 3043 further comprising verifying the decidable and complete data flow.

3056. The method of creating the computer language of aspect 3044 further comprising verifying the decidable and complete data flow.

3057. The method of creating the computer language of aspect 3045 further comprising verifying the decidable and complete data flow.

3058. A method of creating the computer language of aspect 3010 comprising:
designing the language including defining operators and defining data types; and
verifying an FIOSM can be generated for all software enterprise systems created in the language by verifying all software enterprise systems have decidable and complete data flow.

3059. The method of aspect 3058 wherein defining operators includes only specifying operators whose semantics are not ambiguous or cannot invoke infinite code paths.

3060. The method of aspect 3058 wherein the data types comprise enumerable and non-enumerable data types.

3061. The method of aspect 3060 wherein all data elements of the non-enumerated data types are represented as sets.

3062. The method of aspect 3061 wherein all data elements consisting of infinite sets are expressed with a finite lexical notation.

3063. The method of aspect 3061 wherein numeric data types are non-enumerated data types and numeric data elements of the numeric data types are expressed using equalities and/or inequalities.

3064. The method of aspect 3058 wherein verifying decidable and complete data flow comprises verifying both a code path quality and a data flow quality of the language.

3065. The method of aspect 3064 wherein said verifying a code path quality comprises demonstrating all possible code paths within the language can be expressed in a finite tree model.

3066. The method of aspect 3065, wherein the tree model comprises a directed acyclic graph.

3067. The method of aspect 3065 wherein said demonstrating all possible code paths within the language comprises generating a tree model using a tableau algorithm.

3068. The method of aspect 3064, wherein verifying the data flow quality further comprises identifying a set of one or more complete and correct algorithms that can determine the value of any data element in the set of all software enterprise systems written in the language.

3069. The method of aspect 3068 wherein said identifying a set of one or more complete and correct algorithms comprises demonstrating a valid algorithm for each data type associated with the language.

3070. The method of aspect 3069, wherein said demonstrating a valid algorithm for each data type comprises utilizing automated algebraic analysis.

3071. The method of aspect 3069, wherein said demonstrating a valid algorithm for each data type comprises utilizing approximation.

3072. The method of aspect 3058, further comprising: repeating said designing the language after said verifying the decidable and complete data flow if decidable and complete data flow is unverifiable.

3073. The method of aspect 3072, wherein the operations of designing and verifying are repeated iteratively until decidable and complete data flow is verified.

3074. The method of aspect 3058 wherein defining operators includes only specifying operators whose semantics are not ambiguous or result in infinite code paths.

3075. A computer language wherein a finite input output model (FIOSM) can be generated for all software modules created in the language.

3076. The computer language of aspect 3075, wherein the computer language does not include operators having ambiguous semantics or operators capable of invoking infinite code paths.

3077. The computer language of aspect 3076, wherein the infinite code paths comprise infinite loops.

3078. The computer language of aspect 3075, further including a plurality of operators wherein not one of the plurality of operators is capable of invoking an infinite code path in any of the set of all software modules written in the computer language.

3079. The computer language of aspect 3078, wherein the infinite code path comprises an infinite loop.

3080. The computer language of aspect 3075, further including a plurality of operators wherein no combination of operators of the plurality of operators are capable of invoking an infinite loop in any of the set of all software modules written in the computer language.

3081. The computer language of aspect 3080, wherein the infinite code path comprises an infinite loop.

3082. The computer language of aspect 3075, wherein the computer language is a modified version of an existing language.

3083. The computer language of aspect 3082 wherein the existing language is one of C, C+, C++, Java, Basic, Pascal, and Fortran.

3084. The computer language of aspect 3075, wherein all software modules comprise commercially useful software modules having at least 100 lines of code.

3085. The computer language of aspect 3075, wherein all software modules having at least 100 lines of code.

3086. The computer language of aspect 3075, wherein all software modules comprise commercially useful software modules having at least 1,000 lines of code.

3087. The computer language of aspect 3075, wherein all software modules comprise software modules having at least 1,000 lines of code.

3088. The computer language of aspect 3075, wherein all software modules comprise commercially useful software modules having at least 10,000 lines of code.

3089. The computer language of aspect 3075, wherein all software modules comprise software modules having at least 10,000 lines of code.

3090. The computer language of aspect 3075, wherein all software modules comprise commercially useful software modules having at least 100,000 lines of code.

3091. The computer language of aspect 3075, wherein all software modules comprise software modules having at least 100,000 lines of code.

3092. A method of creating the computer language of aspect 3075 comprising: modifying an existing language by removing all operators of the language capable of invoking infinite code paths.

3093. A method of creating the computer language of aspect 3075 comprising: modifying an existing language by removing all operators (i) having ambiguous semantics and (ii) being capable of invoking infinite code paths.

3094. The method of aspect 3092, wherein the existing language is one of C, C+, C++, Java, Basic, Pascal, and Fortran.

3095. The method of aspect 3093, wherein the existing language is one of C, C+, C++, Java, Basic, Pascal, and Fortran.

3096. The method of aspect 3092, further comprising replacing the removed operators with one or more alternative operators incapable of invoking or ambiguous infinite loops.

3097. The method of aspect 3093, further comprising replacing the removed operators with one or more alternative operators incapable of invoking or ambiguous infinite loops.

3098. The method of aspect 3097 wherein a for loop operator is replaced with “sum” operator.

3099. A method of creating the computer language of aspect 3075 comprising modifying an existing computer language.

3100. The method of aspect 3099 wherein said modifying an existing an existing computer language comprises replacing operators capable of invoking infinite code paths with operators incapable of invoking infinite code paths.

3101. The method of aspect 3099 wherein said modifying an existing an existing computer language comprises replacing ambiguous operators with unambiguous operators.

3102. The method of aspect 3099 wherein said modifying an existing an existing computer language comprises replacing operators with ambiguous semantics with operators with unambiguous semantics.

3103. The method of aspect 3099, wherein said modifying an existing an existing computer language comprises redefining one or more data types.

3104. The method of aspect 3099, wherein said modifying an existing an existing computer language comprises replacing one or more data types.

3105. The method of aspect 3100, wherein said modifying an existing an existing computer language comprises redefining one or more data types.

3106. The method of aspect 3100, wherein said modifying an existing an existing computer language comprises replacing one or more data types.

3107. The method of aspect 3101, wherein said modifying an existing an existing computer language comprises redefining one or more data types.

3108. The method of aspect 3101, wherein said modifying an existing an existing computer language comprises replacing one or more data types.

3109. The method of aspect 3102, wherein said modifying an existing an existing computer language comprises redefining one or more data types.

3110. The method of aspect 3102, wherein said modifying an existing an existing computer language comprises replacing one or more data types.

3111. The method of creating the computer language of aspect 3099 further comprising verifying the decidable and complete data flow.

3112. The method of creating the computer language of aspect 3100 further comprising verifying the decidable and complete data flow.

3113. The method of creating the computer language of aspect 3101 further comprising verifying the decidable and complete data flow.

3114. The method of creating the computer language of aspect 3102 further comprising verifying the decidable and complete data flow.

3115. The method of creating the computer language of aspect 3103 further comprising verifying the decidable and complete data flow.

3116. The method of creating the computer language of aspect 3104 further comprising verifying the decidable and complete data flow.

3117. The method of creating the computer language of aspect 3105 further comprising verifying the decidable and complete data flow.

3118. The method of creating the computer language of aspect 3106 further comprising verifying the decidable and complete data flow.

3119. The method of creating the computer language of aspect 3107 further comprising verifying the decidable and complete data flow.

3120. The method of creating the computer language of aspect 3108 further comprising verifying the decidable and complete data flow.

3121. The method of creating the computer language of aspect 3109 further comprising verifying the decidable and complete data flow.

3122. The method of creating the computer language of aspect 3110 further comprising verifying the decidable and complete data flow.

3123. A method of creating the computer language of aspect 3075 comprising:
designing the language including defining operators and defining data types; and
verifying an FIOSM can be generated for all software modules created in the language by verifying all software modules have decidable and complete data flow.

3124. The method of aspect 3123 wherein defining operators includes only specifying operators whose semantics are not ambiguous or cannot invoke infinite code paths.

3125. The method of aspect 3123 wherein the data types comprise enumerable and non-enumerable data types.

3126. The method of aspect 3125 wherein all data elements of the non-enumerated data types are represented as sets.

3127. The method of aspect 3126 wherein all data elements consisting of infinite sets are expressed with a finite lexical notation.

3128. The method of aspect 3126 wherein numeric data types are non-enumerated data types and numeric data elements of the numeric data types are expressed using equalities and/or inequalities.

3129. The method of aspect 3123 wherein verifying decidable and complete data flow comprises verifying both a code path quality and a data flow quality of the language.

3130. The method of aspect 3129 wherein said verifying a code path quality comprises demonstrating all possible code paths within the language can be expressed in a finite tree model.

3131. The method of aspect 3130, wherein the tree model comprises a directed acyclic graph.

3132. The method of aspect 3130 wherein said demonstrating all possible code paths within the language comprises generating a tree model using a tableau algorithm.

3133. The method of aspect 3129, wherein verifying the data flow quality further comprises identifying a set of one or more complete and correct algorithms that can determine the value of any data element in the set of all software modules written in the language.

3134. The method of aspect 3133 wherein said identifying a set of one or more complete and correct algorithms comprises demonstrating a valid algorithm for each data type associated with the language.

3135. The method of aspect 3134, wherein said demonstrating a valid algorithm for each data type comprises utilizing automated algebraic analysis.

3136. The method of aspect 3134, wherein said demonstrating a valid algorithm for each data type comprises utilizing approximation.

3137. The method of aspect 3123, further comprising: repeating said designing the language after said verifying the decidable and complete data flow if decidable and complete data flow is unverifiable.

3138. The method of aspect 3137, wherein the operations of designing and verifying are repeated iteratively until decidable and complete data flow is verified.

3139. The method of aspect 3123 wherein defining operators includes only specifying operators whose semantics are not ambiguous or result in infinite code paths.

3140. A computer language wherein a finite input output model (FIOSM) can be generated for all software procedures created in the language.

3141. The computer language of aspect 3140, wherein the computer language does not include operators having ambiguous semantics or operators capable of invoking infinite code paths.

3142. The computer language of aspect 3141, wherein the infinite code paths comprise infinite loops.

3143. The computer language of aspect 3140, further including a plurality of operators wherein not one of the plurality of operators is capable of invoking an infinite code path in any of the set of all software procedures written in the computer language.

3144. The computer language of aspect 3143, wherein the infinite code path comprises an infinite loop.

3145. The computer language of aspect 3140, further including a plurality of operators wherein no combination of operators of the plurality of operators are capable of invoking an infinite loop in any of the set of all software procedures written in the computer language.

3146. The computer language of aspect 3145, wherein the infinite code path comprises an infinite loop.

3147. The computer language of aspect 3140, wherein the computer language is a modified version of an existing language.

3148. The computer language of aspect 3147 wherein the existing language is one of C, C+, C++, Java, Basic, Pascal, and Fortran.

3149. The computer language of aspect 3140, wherein all software procedures comprise commercially useful software procedures having at least 1,000 lines of code.

3150. The computer language of aspect 3140, wherein all software procedures having at least 1,000 lines of code.

3151. The computer language of aspect 3140, wherein all software procedures comprise commercially useful software procedures having at least 10,000 lines of code.

3152. The computer language of aspect 3140, wherein all software procedures comprise software procedures having at least 10,000 lines of code.

3153. The computer language of aspect 3140, wherein all software procedures comprise commercially useful software procedures having at least 100,000 lines of code.

3154. The computer language of aspect 3140, wherein all software procedures comprise software procedures having at least 100,000 lines of code.

3155. The computer language of aspect 3140, wherein all software procedures comprise commercially useful software procedures having at least 1,000,000 lines of code.

3156. The computer language of aspect 3140, wherein all software procedures comprise software procedures having at least 1,000,000 lines of code.

3157. A method of creating the computer language of aspect 3140 comprising: modifying an existing language by removing all operators of the language capable of invoking infinite code paths.

3158. A method of creating the computer language of aspect 3140 comprising: modifying an existing language by removing all operators (i) having ambiguous semantics and (ii) being capable of invoking infinite code paths.

3159. The method of aspect 3157, wherein the existing language is one of C, C+, C++, Java, Basic, Pascal, and Fortran.

3160. The method of aspect 3158, wherein the existing language is one of C, C+, C++, Java, Basic, Pascal, and Fortran.

3161. The method of aspect 3157, further comprising replacing the removed operators with one or more alternative operators incapable of invoking or ambiguous infinite loops.

3162. The method of aspect 3158, further comprising replacing the removed operators with one or more alternative operators incapable of invoking or ambiguous infinite loops.

3163. The method of aspect 3162 wherein a for loop operator is replaced with “sum” operator.

3164. A method of creating the computer language of aspect 3140 comprising modifying an existing computer language.

3165. The method of aspect 3164 wherein said modifying an existing an existing computer language comprises replacing operators capable of invoking infinite code paths with operators incapable of invoking infinite code paths.

3166. The method of aspect 3164 wherein said modifying an existing an existing computer language comprises replacing ambiguous operators with unambiguous operators.

3167. The method of aspect 3164 wherein said modifying an existing an existing computer language comprises replacing operators with ambiguous semantics with operators with unambiguous semantics.

3168. The method of aspect 3164, wherein said modifying an existing an existing computer language comprises redefining one or more data types.

3169. The method of aspect 3164, wherein said modifying an existing an existing computer language comprises replacing one or more data types.

3170. The method of aspect 3165, wherein said modifying an existing an existing computer language comprises redefining one or more data types.

3171. The method of aspect 3165, wherein said modifying an existing an existing computer language comprises replacing one or more data types.

3172. The method of aspect 3166, wherein said modifying an existing an existing computer language comprises redefining one or more data types.

3173. The method of aspect 3166, wherein said modifying an existing an existing computer language comprises replacing one or more data types.

3174. The method of aspect 3167, wherein said modifying an existing an existing computer language comprises redefining one or more data types.

3175. The method of aspect 3167, wherein said modifying an existing an existing computer language comprises replacing one or more data types.

3176. The method of creating the computer language of aspect 3164 further comprising verifying the decidable and complete data flow.

3177. The method of creating the computer language of aspect 3165 further comprising verifying the decidable and complete data flow.

3178. The method of creating the computer language of aspect 3166 further comprising verifying the decidable and complete data flow.

3179. The method of creating the computer language of aspect 3167 further comprising verifying the decidable and complete data flow.

3180. The method of creating the computer language of aspect 3168 further comprising verifying the decidable and complete data flow.

3181. The method of creating the computer language of aspect 3169 further comprising verifying the decidable and complete data flow.

3182. The method of creating the computer language of aspect 3170 further comprising verifying the decidable and complete data flow.

3183. The method of creating the computer language of aspect 3171 further comprising verifying the decidable and complete data flow.

3184. The method of creating the computer language of aspect 3172 further comprising verifying the decidable and complete data flow.

3185. The method of creating the computer language of aspect 3173 further comprising verifying the decidable and complete data flow.

3186. The method of creating the computer language of aspect 3174 further comprising verifying the decidable and complete data flow.

3187. The method of creating the computer language of aspect 3175 further comprising verifying the decidable and complete data flow.

3188. A method of creating the computer language of aspect 3140 comprising:
designing the language including defining operators and defining data types; and
verifying an FIOSM can be generated for all software procedures created in the language by verifying all software procedures have decidable and complete data flow.

3189. The method of aspect 3188 wherein defining operators includes only specifying operators whose semantics are not ambiguous or cannot invoke infinite code paths.

3190. The method of aspect 3188 wherein the data types comprise enumerable and non-enumerable data types.

3191. The method of aspect 3190 wherein all data elements of the non-enumerated data types are represented as sets.

3192. The method of aspect 3191 wherein all data elements consisting of infinite sets are expressed with a finite lexical notation.

3193. The method of aspect 3191 wherein numeric data types are non-enumerated data types and numeric data elements of the numeric data types are expressed using equalities and/or inequalities.

3194. The method of aspect 3188 wherein verifying decidable and complete data flow comprises verifying both a code path quality and a data flow quality of the language.

3195. The method of aspect 3194 wherein said verifying a code path quality comprises demonstrating all possible code paths within the language can be expressed in a finite tree model.

3196. The method of aspect 3195, wherein the tree model comprises a directed acyclic graph.

3197. The method of aspect 3195 wherein said demonstrating all possible code paths within the language comprises generating a tree model using a tableau algorithm.

3198. The method of aspect 3194, wherein verifying the data flow quality further comprises identifying a set of one or more complete and correct algorithms that can determine the value of any data element in the set of all software procedures written in the language.

3199. The method of aspect 3198 wherein said identifying a set of one or more complete and correct algorithms comprises demonstrating a valid algorithm for each data type associated with the language.

3200. The method of aspect 3199, wherein said demonstrating a valid algorithm for each data type comprises utilizing automated algebraic analysis.

3201. The method of aspect 3199, wherein said demonstrating a valid algorithm for each data type comprises utilizing approximation.

3202. The method of aspect 3188, further comprising: repeating said designing the language after said verifying the decidable and complete data flow if decidable and complete data flow is unverifiable.

3203. The method of aspect 3202, wherein the operations of designing and verifying are repeated iteratively until decidable and complete data flow is verified.

3204. The method of aspect 3188 wherein defining operators includes only specifying operators whose semantics are not ambiguous or result in infinite code paths.

3205. A computer language wherein a finite input output model (FIOSM) can be generated for all software routines created in the language.

3206. The computer language of aspect 3205, wherein the computer language does not include operators having ambiguous semantics or operators capable of invoking infinite code paths.

3207. The computer language of aspect 3206, wherein the infinite code paths comprise infinite loops.

3208. The computer language of aspect 3205, further including a plurality of operators wherein not one of the plurality of operators is capable of invoking an infinite code path in any of the set of all software routines written in the computer language.

3209. The computer language of aspect 3208, wherein the infinite code path comprises an infinite loop.

3210. The computer language of aspect 3205, further including a plurality of operators wherein no combination of operators of the plurality of operators are capable of invoking an infinite loop in any of the set of all software routines written in the computer language.

3211. The computer language of aspect 3210, wherein the infinite code path comprises an infinite loop.

3212. The computer language of aspect 3205, wherein the computer language is a modified version of an existing language.

3213. The computer language of aspect 3212 wherein the existing language is one of C, C+, C++, Java, Basic, Pascal, and Fortran.

3214. The computer language of aspect 3205, wherein all software routines comprise commercially useful software routines having at least 100 lines of code.

3215. The computer language of aspect 3205, wherein all software routines having at least 100 lines of code.

3216. The computer language of aspect 3205, wherein all software routines comprise commercially useful software routines having at least 1,000 lines of code.

3217. The computer language of aspect 3205, wherein all software routines comprise software routines having at least 1,000 lines of code.

3218. The computer language of aspect 3205, wherein all software routines comprise commercially useful software routines having at least 10,000 lines of code.

3219. The computer language of aspect 3205, wherein all software routines comprise software routines having at least 10,000 lines of code.

3220. The computer language of aspect 3205, wherein all software routines comprise commercially useful software routines having at least 100,000 lines of code.

3221. The computer language of aspect 3205, wherein all software routines comprise software routines having at least 100,000 lines of code.

3222. A method of creating the computer language of aspect 3205 comprising: modifying an existing language by removing all operators of the language capable of invoking infinite code paths.

3223. A method of creating the computer language of aspect 3205 comprising: modifying an existing language by removing all operators (i) having ambiguous semantics and (ii) being capable of invoking infinite code paths.

3224. The method of aspect 3222, wherein the existing language is one of C, C+, C++, Java, Basic, Pascal, and Fortran.

3225. The method of aspect 3223, wherein the existing language is one of C, C+, C++, Java, Basic, Pascal, and Fortran.

3226. The method of aspect 3222, further comprising replacing the removed operators with one or more alternative operators incapable of invoking or ambiguous infinite loops.

3227. The method of aspect 3223, further comprising replacing the removed operators with one or more alternative operators incapable of invoking or ambiguous infinite loops.

3228. The method of aspect 3227 wherein a for loop operator is replaced with “sum” operator.

3229. A method of creating the computer language of aspect 3205 comprising modifying an existing computer language.

3230. The method of aspect 3229 wherein said modifying an existing an existing computer language comprises replacing operators capable of invoking infinite code paths with operators incapable of invoking infinite code paths.

3231. The method of aspect 3229 wherein said modifying an existing an existing computer language comprises replacing ambiguous operators with unambiguous operators.

3232. The method of aspect 3229 wherein said modifying an existing an existing computer language comprises replacing operators with ambiguous semantics with operators with unambiguous semantics.

3233. The method of aspect 3229, wherein said modifying an existing an existing computer language comprises redefining one or more data types.

3234. The method of aspect 3229, wherein said modifying an existing an existing computer language comprises replacing one or more data types.

3235. The method of aspect 3230, wherein said modifying an existing an existing computer language comprises redefining one or more data types.

3236. The method of aspect 3230, wherein said modifying an existing an existing computer language comprises replacing one or more data types.

3237. The method of aspect 3231, wherein said modifying an existing an existing computer language comprises redefining one or more data types.

3238. The method of aspect 3231, wherein said modifying an existing an existing computer language comprises replacing one or more data types.

3239. The method of aspect 3232, wherein said modifying an existing an existing computer language comprises redefining one or more data types.

3240. The method of aspect 3232, wherein said modifying an existing an existing computer language comprises replacing one or more data types.

3241. The method of creating the computer language of aspect 3229 further comprising verifying the decidable and complete data flow.

3242. The method of creating the computer language of aspect 3230 further comprising verifying the decidable and complete data flow.

3243. The method of creating the computer language of aspect 3231 further comprising verifying the decidable and complete data flow.

3244. The method of creating the computer language of aspect 3232 further comprising verifying the decidable and complete data flow.

3245. The method of creating the computer language of aspect 3233 further comprising verifying the decidable and complete data flow.

3246. The method of creating the computer language of aspect 3234 further comprising verifying the decidable and complete data flow.

3247. The method of creating the computer language of aspect 3235 further comprising verifying the decidable and complete data flow.

3248. The method of creating the computer language of aspect 3236 further comprising verifying the decidable and complete data flow.

3249. The method of creating the computer language of aspect 3237 further comprising verifying the decidable and complete data flow.

3250. The method of creating the computer language of aspect 3238 further comprising verifying the decidable and complete data flow.

3251. The method of creating the computer language of aspect 3239 further comprising verifying the decidable and complete data flow.

3252. The method of creating the computer language of aspect 3240 further comprising verifying the decidable and complete data flow.

3253. A method of creating the computer language of aspect 3205 comprising:
designing the language including defining operators and defining data types; and
verifying an FIOSM can be generated for all software routines created in the language by verifying all software routines have decidable and complete data flow.

3254. The method of aspect 3253 wherein defining operators includes only specifying operators whose semantics are not ambiguous or cannot invoke infinite code paths.

3255. The method of aspect 3253 wherein the data types comprise enumerable and non-enumerable data types.

3256. The method of aspect 3255 wherein all data elements of the non-enumerated data types are represented as sets.

3257. The method of aspect 3256 wherein all data elements consisting of infinite sets are expressed with a finite lexical notation.

3258. The method of aspect 3256 wherein numeric data types are non-enumerated data types and numeric data elements of the numeric data types are expressed using equalities and/or inequalities.

3259. The method of aspect 3253 wherein verifying decidable and complete data flow comprises verifying both a code path quality and a data flow quality of the language.

3260. The method of aspect 3259 wherein said verifying a code path quality comprises demonstrating all possible code paths within the language can be expressed in a finite tree model.

3261. The method of aspect 3260, wherein the tree model comprises a directed acyclic graph.

3262. The method of aspect 3260 wherein said demonstrating all possible code paths within the language comprises generating a tree model using a tableau algorithm.

3263. The method of aspect 3259, wherein verifying the data flow quality further comprises identifying a set of one or more complete and correct algorithms that can determine the value of any data element in the set of all software routines written in the language.

3264. The method of aspect 3263 wherein said identifying a set of one or more complete and correct algorithms comprises demonstrating a valid algorithm for each data type associated with the language.

3265. The method of aspect 3264, wherein said demonstrating a valid algorithm for each data type comprises utilizing automated algebraic analysis.

3266. The method of aspect 3264, wherein said demonstrating a valid algorithm for each data type comprises utilizing approximation.

3267. The method of aspect 3253, further comprising: repeating said designing the language after said verifying the decidable and complete data flow if decidable and complete data flow is unverifiable.

3268. The method of aspect 3267, wherein the operations of designing and verifying are repeated iteratively until decidable and complete data flow is verified.

3269. The method of aspect 3253 wherein defining operators includes only specifying operators whose semantics are not ambiguous or result in infinite code paths.

3270. A computer language wherein each operator of a set consisting of all operators in the language is incapable of invoking an infinite code path.

3271. The computer language of aspect 3270, wherein each operator of the set of operators has unambiguous semantics.

3272. The computer language of aspect 3270 wherein the infinite code path comprises an infinite loop.

3273. The computer language of aspect 3270, wherein any combination of operators of the set of operators are incapable of invoking an infinite or ambiguous code path.

3274. The computer language of aspect 3273 wherein the infinite code path comprises an infinite loop.

3275. The computer language of aspect 3270, wherein the computer language is a modified version of an existing language.

3276. The computer language of aspect 3275 wherein the existing language is one of C, C+, C++, Java, Basic, Pascal, and Fortran.

3277. The computer language of aspect 3270, wherein all programs comprise commercially useful programs having at least 1,000 lines of code.

3278. The computer language of aspect 3270, wherein all programs comprise programs having at least 1,000 lines of code.

3279. The computer language of aspect 3270, wherein all programs comprise commercially useful programs having at least 10,000 lines of code.

3280. The computer language of aspect 3270, wherein all programs comprise programs having at least 10,000 lines of code.

3281. The computer language of aspect 3270, wherein all programs comprise commercially useful programs having at least 100,000 lines of code.

3282. The computer language of aspect 3270, wherein all programs comprise programs having at least 100,000 lines of code.

3283. The computer language of aspect 3270, wherein all programs comprise commercially useful programs having at least 1,000,000 lines of code.

3284. The computer language of aspect 3270, wherein all programs comprise programs having at least 1,000,000 lines of code.

3285. A method of creating the computer language of aspect 3270 comprising: modifying an existing language by removing all operators capable of invoking infinite code paths.

3286. A method of creating the computer language of aspect 3270 comprising: modifying an existing language by removing all operators (i) having ambiguous semantics and (ii) being capable of invoking infinite code paths.

3287. The method of aspect 3285, wherein the existing language is one of C, C+, C++, Java, Basic, Pascal, and Fortran.

3288. The method of aspect 3286, wherein the existing language is one of C, C+, C++, Java, Basic, Pascal, and Fortran.

3289. The method of aspect 3285, further comprising replacing the removed operators with one or more alternative operators incapable of invoking or ambiguous infinite loops.

3290. The method of aspect 3286, further comprising replacing the removed operators with one or more alternative operators incapable of invoking or ambiguous infinite loops.

3291. The method of aspect 3290 wherein a for loop operator is replaced with “sum” operator.

3292. A method of creating the computer language of aspect 3270 comprising modifying an existing computer language.

3293. The method of aspect 3292 wherein said modifying an existing an existing computer language comprises replacing operators capable of invoking infinite code paths with operators incapable of invoking infinite code paths.

3294. The method of aspect 3292 wherein said modifying an existing an existing computer language comprises replacing ambiguous operators with unambiguous operators.

3295. The method of aspect 3292 wherein said modifying an existing an existing computer language comprises replacing operators with ambiguous semantics with operators with unambiguous semantics.

3296. The method of aspect 3292, wherein said modifying an existing an existing computer language comprises redefining one or more data types.

3297. The method of aspect 3292, wherein said modifying an existing an existing computer language comprises replacing one or more data types.

3298. The method of aspect 3293, wherein said modifying an existing an existing computer language comprises redefining one or more data types.

3299. The method of aspect 3293, wherein said modifying an existing an existing computer language comprises replacing one or more data types.

3300. The method of aspect 3294, wherein said modifying an existing an existing computer language comprises redefining one or more data types.

3301. The method of aspect 3294, wherein said modifying an existing an existing computer language comprises replacing one or more data types.

3302. The method of aspect 3295, wherein said modifying an existing an existing computer language comprises redefining one or more data types.

3303. The method of aspect 3295, wherein said modifying an existing an existing computer language comprises replacing one or more data types.

3304. A method of creating the computer language of aspect 3270 comprising:
designing the language including defining the set of all operators and defining a set of data types; and
verifying that each operator of the set of operators is incapable of invoking an infinite loop.

3305. The method of aspect 3304 wherein the set of data types includes enumerable and non-enumerable data types.

3306. The method of aspect 3305 wherein all data elements of the non-enumerated data types are represented as sets.

3307. The method of aspect 3306 wherein all data elements consisting of infinite sets are expressed with a finite lexical notation.

3308. The method of aspect 3306 wherein numeric data types are non-enumerated data types and numeric data elements of the numeric data types are expressed using equalities and/or inequalities.

3309. The method of aspect 3304 wherein said verifying that each operator of the set of operators is incapable of invoking an infinite loop comprises verifying both a code path quality and a data flow quality of the language.

3310. The method of aspect 3309 wherein said verifying a code path quality comprises demonstrating all possible code paths within the language can be expressed in a finite tree model.

3311. The method of aspect 3310, wherein the tree model comprises a directed acyclic graph.

3312. The method of aspect 3310 wherein said demonstrating all possible code paths within the language comprises generating a tree model using a tableau algorithm.

3313. The method of aspect 3309, wherein verifying the data flow quality further comprises identifying a set of one or more complete and correct algorithms that can determine the value of any data element in the set of all programs written in the language.

3314. The method of aspect 3313 wherein said identifying a set of one or more complete and correct algorithms comprises demonstrating a valid algorithm for each data type associated with the language.

3315. The method of aspect 3314, wherein said demonstrating a valid algorithm for each data type comprises utilizing automated algebraic analysis.

3316. The method of aspect 3314, wherein said demonstrating a valid algorithm for each data type comprises utilizing approximation.

3317. The method of aspect 3304, further comprising: repeating said designing the language after said that each operator of the set of operators is incapable of invoking an infinite loop is unverifiable.

3318. The method of aspect 3317, wherein the operations of designing and verifying are repeated iteratively until decidable and complete data flow is verified.

3319. The method of creating the computer language of aspect 3292 further comprising verifying the decidable and complete data flow.

3320. The method of creating the computer language of aspect 3293 further comprising verifying the decidable and complete data flow.

3321. The method of creating the computer language of aspect 3294 further comprising verifying the decidable and complete data flow.

3322. The method of creating the computer language of aspect 3295 further comprising verifying the decidable and complete data flow.

3323. The method of creating the computer language of aspect 3296 further comprising verifying the decidable and complete data flow.

3324. The method of creating the computer language of aspect 3297 further comprising verifying the decidable and complete data flow.

3325. The method of creating the computer language of aspect 3298 further comprising verifying the decidable and complete data flow.

3326. The method of creating the computer language of aspect 3299 further comprising verifying the decidable and complete data flow.

3327. The method of creating the computer language of aspect 3300 further comprising verifying the decidable and complete data flow.

3328. The method of creating the computer language of aspect 3301 further comprising verifying the decidable and complete data flow.

3329. The method of creating the computer language of aspect 3302 further comprising verifying the decidable and complete data flow.

3330. The method of creating the computer language of aspect 3303 further comprising verifying the decidable and complete data flow.

3331. A computer language wherein each operator of a set consisting of all operators in the language has unambiguous semantics and is incapable of an invoking infinite code path.

3332. The computer language of aspect 3331 wherein the infinite code path comprises an infinite loop.

3333. The computer language of aspect 3331, wherein any combination of operators of the set of operators are incapable of invoking an infinite or ambiguous code path.

3334. The computer language of aspect 3333 wherein the infinite or ambiguous code path comprises an infinite or ambiguous loop.

3335. The computer language of aspect 3331, wherein the computer language is a modified version of an existing language.

3336. The computer language of aspect 3335 wherein the existing language is one of C, C+, C++, Java, Basic, Pascal, and Fortran.

3337. The computer language of aspect 3331, wherein all programs comprise commercially useful programs having at least 1,000 lines of code.

3338. The computer language of aspect 3331, wherein all programs comprise programs having at least 1,000 lines of code.

3339. The computer language of aspect 3331, wherein all programs comprise commercially useful programs having at least 10,000 lines of code.

3340. The computer language of aspect 3331, wherein all programs comprise programs having at least 10,000 lines of code.

3341. The computer language of aspect 3331, wherein all programs comprise commercially useful programs having at least 100,000 lines of code.

3342. The computer language of aspect 3331, wherein all programs comprise programs having at least 100,000 lines of code.

3343. The computer language of aspect 3331, wherein all programs comprise commercially useful programs having at least 1,000,000 lines of code.

3344. The computer language of aspect 3331, wherein all programs comprise programs having at least 1,000,000 lines of code.

3345. A method of creating the computer language of aspect 3331 comprising: modifying an existing language by removing all operators capable of invoking infinite code paths.

3346. A method of creating the computer language of aspect 3331 comprising: modifying an existing language by removing all operators (i) having ambiguous semantics and (ii) being capable of invoking infinite code paths.

3347. The method of aspect 3345, wherein the existing language is one of C, C+, C++, Java, Basic, Pascal, and Fortran.

3348. The method of aspect 3346, wherein the existing language is one of C, C+, C++, Java, Basic, Pascal, and Fortran.

3349. The method of aspect 3345, further comprising replacing the removed operators with one or more alternative operators incapable of invoking or ambiguous infinite loops.

3350. The method of aspect 3346, further comprising replacing the removed operators with one or more alternative operators incapable of invoking or ambiguous infinite loops.

3351. The method of aspect 3350 wherein a for loop operator is replaced with “sum” operator.

3352. A method of creating the computer language of aspect 3331 comprising modifying an existing computer language.

3353. The method of aspect 3352 wherein said modifying an existing an existing computer language comprises replacing operators capable of invoking infinite code paths with operators incapable of invoking infinite code paths.

3354. The method of aspect 3352 wherein said modifying an existing an existing computer language comprises replacing ambiguous operators with unambiguous operators.

3355. The method of aspect 3352 wherein said modifying an existing an existing computer language comprises replacing operators with ambiguous semantics with operators with unambiguous semantics.

3356. The method of aspect 3352, wherein said modifying an existing an existing computer language comprises redefining one or more data types.

3357. The method of aspect 3352, wherein said modifying an existing an existing computer language comprises replacing one or more data types.

3358. The method of aspect 3353, wherein said modifying an existing an existing computer language comprises redefining one or more data types.

3359. The method of aspect 3353, wherein said modifying an existing an existing computer language comprises replacing one or more data types.

3360. The method of aspect 3354, wherein said modifying an existing an existing computer language comprises redefining one or more data types.

3361. The method of aspect 3354, wherein said modifying an existing an existing computer language comprises replacing one or more data types.

3362. The method of aspect 3355, wherein said modifying an existing an existing computer language comprises redefining one or more data types.

3363. The method of aspect 3355, wherein said modifying an existing an existing computer language comprises replacing one or more data types.

3364. A method of creating the computer language of aspect 3331 comprising:
designing the language including defining the set of all operators and defining a set of data types; and
verifying that each operator of the set of operators is incapable of invoking an infinite loop.

3365. The method of aspect 3364 wherein the set of data types includes enumerable and non-enumerable data types.

3366. The method of aspect 3365 wherein all data elements of the non-enumerated data types are represented as sets.

3367. The method of aspect 3366 wherein all data elements consisting of infinite sets are expressed with a finite lexical notation.

3368. The method of aspect 3366 wherein numeric data types are non-enumerated data types and numeric data elements of the numeric data types are expressed using equalities and/or inequalities.

3369. The method of aspect 3364 wherein said verifying that each operator of the set of operators is incapable of invoking an infinite loop comprises verifying both a code path quality and a data flow quality of the language.

3370. The method of aspect 3369 wherein said verifying a code path quality comprises demonstrating all possible code paths within the language can be expressed in a finite tree model.

3371. The method of aspect 3370, wherein the tree model comprises a directed acyclic graph.

3372. The method of aspect 3370 wherein said demonstrating all possible code paths within the language comprises generating a tree model using a tableau algorithm.

3373. The method of aspect 3369, wherein verifying the data flow quality further comprises identifying a set of one or more complete and correct algorithms that can determine the value of any data element in the set of all programs written in the language.

3374. The method of aspect 3373 wherein said identifying a set of one or more complete and correct algorithms comprises demonstrating a valid algorithm for each data type associated with the language.

3375. The method of aspect 3374, wherein said demonstrating a valid algorithm for each data type comprises utilizing automated algebraic analysis.

3376. The method of aspect 3374, wherein said demonstrating a valid algorithm for each data type comprises utilizing approximation.

3377. The method of aspect 3364, further comprising: repeating said designing the language after said that each operator of the set of operators is incapable of invoking an infinite loop is unverifiable.

3378. The method of aspect 3377, wherein the operations of designing and verifying are repeated iteratively until decidable and complete data flow is verified.

3379. The method of creating the computer language of aspect 3352 further comprising verifying the decidable and complete data flow.

3380. The method of creating the computer language of aspect 3353 further comprising verifying the decidable and complete data flow.

3381. The method of creating the computer language of aspect 3354 further comprising verifying the decidable and complete data flow.

3382. The method of creating the computer language of aspect 3355 further comprising verifying the decidable and complete data flow.

3383. The method of creating the computer language of aspect 3356 further comprising verifying the decidable and complete data flow.

3384. The method of creating the computer language of aspect 3357 further comprising verifying the decidable and complete data flow.

3385. The method of creating the computer language of aspect 3358 further comprising verifying the decidable and complete data flow.

3386. The method of creating the computer language of aspect 3359 further comprising verifying the decidable and complete data flow.

3387. The method of creating the computer language of aspect 3360 further comprising verifying the decidable and complete data flow.

3388. The method of creating the computer language of aspect 3361 further comprising verifying the decidable and complete data flow.

3389. The method of creating the computer language of aspect 3362 further comprising verifying the decidable and complete data flow.

3390. The method of creating the computer language of aspect 3363 further comprising verifying the decidable and complete data flow.

3391. A computer language wherein a set of all programs created in the language have a decidable and complete data flow.

3392. The computer language of aspect 3391, wherein the computer language does not include operators having ambiguous semantics or operators capable of invoking infinite code paths.

3393. The computer language of aspect 3391, further including a plurality of operators wherein not one of the plurality of operators is capable of invoking an infinite code path in any of the set of all programs written in the computer language.

3394. The computer language of aspect 3393, wherein the infinite code path comprises an infinite loop.

3395. The computer language of aspect 3391 further including a plurality of operators wherein any one operator or any combination of operators of the plurality of operators cannot invoke an infinite or ambiguous code path.

3396. The computer language of aspect 3395, wherein the infinite or ambiguous code path comprises an infinite or ambiguous loop.

3397. The computer language of aspect 3391, further including a plurality of operators wherein no combination of operators of the plurality of operators are capable of invoking an infinite code path in any of the set of all programs written in the computer language.

3398. The computer language of aspect 3397, wherein the infinite code path comprises an infinite loop.

3399. The computer language of aspect 3391, wherein the computer language is a modified version of an existing language.

3400. The computer language of aspect 3399 wherein the existing language is one of C, C+, C++, Java, Basic, Pascal, and Fortran.

3401. The computer language of aspect 3391, wherein all programs comprise commercially useful programs having at least 1,000 lines of code.

3402. The computer language of aspect 3391, wherein all programs comprise programs having at least 1,000 lines of code.

3403. The computer language of aspect 3391, wherein all programs comprise commercially useful programs having at least 10,000 lines of code.

3404. The computer language of aspect 3391, wherein all programs comprise programs having at least 10,000 lines of code.

3405. The computer language of aspect 3391, wherein all programs comprise commercially useful programs having at least 100,000 lines of code.

3406. The computer language of aspect 3391, wherein all programs comprise programs having at least 100,000 lines of code.

3407. The computer language of aspect 3391, wherein all programs comprise commercially useful programs having at least 1,000,000 lines of code.

3408. The computer language of aspect 3391, wherein all programs comprise programs having at least 10,000,000 lines of code.

3409. A method of creating the computer language of aspect 3391 comprising: modifying an existing language by removing all operators of the language capable of invoking infinite code paths.

3410. A method of creating the computer language of aspect 3391 comprising: modifying an existing language by removing all operators (i) having ambiguous semantics and (ii) being capable of invoking infinite code paths.

3411. The method of aspect 3409, wherein the existing language is one of C, C+, C++, Java, Basic, Pascal, and Fortran.

3412. The method of aspect 3410, wherein the existing language is one of C, C+, C++, Java, Basic, Pascal, and Fortran.

3413. The method of aspect 3409, further comprising replacing the removed operators with one or more alternative operators incapable of invoking or ambiguous infinite loops.

3414. The method of aspect 3410, further comprising replacing the removed operators with one or more alternative operators incapable of invoking or ambiguous infinite loops.

3415. The method of aspect 3414 wherein a for loop operator is replaced with “sum” operator.

3416. A method of creating the computer language of aspect 3391 comprising modifying an existing computer language.

3417. The method of aspect 3416 wherein said modifying an existing an existing computer language comprises replacing operators capable of invoking infinite code paths with operators incapable of invoking infinite code paths.

3418. The method of aspect 3416 wherein said modifying an existing an existing computer language comprises replacing ambiguous operators with unambiguous operators.

3419. The method of aspect 3416 wherein said modifying an existing an existing computer language comprises replacing operators with ambiguous semantics with operators with unambiguous semantics.

3420. The method of aspect 3416, wherein said modifying an existing an existing computer language comprises redefining one or more data types.

3421. The method of aspect 3416, wherein said modifying an existing an existing computer language comprises replacing one or more data types.

3422. The method of aspect 3417, wherein said modifying an existing an existing computer language comprises redefining one or more data types.

3423. The method of aspect 3417, wherein said modifying an existing an existing computer language comprises replacing one or more data types.

3424. The method of aspect 3418, wherein said modifying an existing an existing computer language comprises redefining one or more data types.

3425. The method of aspect 3418, wherein said modifying an existing an existing computer language comprises replacing one or more data types.

3426. The method of aspect 3419, wherein said modifying an existing an existing computer language comprises redefining one or more data types.

3427. The method of aspect 3419, wherein said modifying an existing an existing computer language comprises replacing one or more data types.

3428. A method of creating the computer language of aspect 3391 comprising:
designing the language including defining operators and defining data types; and
verifying the decidable and complete data flow.

3429. The method of aspect 3428 wherein defining operators includes only specifying operators whose semantics are not ambiguous or cannot invoke infinite code paths.

3430. The method of aspect 3428 wherein the data types comprise enumerable and non-enumerable data types.

3431. The method of aspect 3430 wherein all data elements of the non-enumerated data types are represented as sets.

3432. The method of aspect 3431 wherein all data elements consisting of infinite sets are expressed with a finite lexical notation.

3433. The method of aspect 3431 wherein numeric data types are non-enumerated data types and numeric data elements of the numeric data types are expressed using equalities and/or inequalities.

3434. The method of aspect 3428 wherein verifying decidable and complete data flow comprises verifying both a code path quality and a data flow quality of the language.

3435. The method of aspect 3434 wherein said verifying a code path quality comprises demonstrating all possible code paths within the language can be expressed in a finite tree model.

3436. The method of aspect 3435, wherein the tree model comprises a directed acyclic graph.

3437. The method of aspect 3435 wherein said demonstrating all possible code paths within the language comprises generating a tree model using a tableau algorithm.

3438. The method of aspect 3434, wherein verifying the data flow quality further comprises identifying a set of one or more complete and correct algorithms that can determine the value of any data element in the set of all programs written in the language.

3439. The method of aspect 3438 wherein said identifying a set of one or more complete and correct algorithms comprises demonstrating a valid algorithm for each data type associated with the language.

3440. The method of aspect 3439, wherein said demonstrating a valid algorithm for each data type comprises utilizing automated algebraic analysis.

3441. The method of aspect 3439, wherein said demonstrating a valid algorithm for each data type comprises utilizing approximation.

3442. The method of aspect 3428, further comprising: repeating said designing the language after said verifying the decidable and complete data flow if decidable and complete data flow is unverifiable.

3443. The method of aspect 3442, wherein the operations of designing and verifying are repeated iteratively until decidable and complete data flow is verified.

3444. The method of creating the computer language of aspect 3416 further comprising verifying the decidable and complete data flow.

3445. The method of creating the computer language of aspect 3417 further comprising verifying the decidable and complete data flow.

3446. The method of creating the computer language of aspect 3418 further comprising verifying the decidable and complete data flow.

3447. The method of creating the computer language of aspect 3419 further comprising verifying the decidable and complete data flow.

3448. The method of creating the computer language of aspect 3420 further comprising verifying the decidable and complete data flow.

3449. The method of creating the computer language of aspect 3421 further comprising verifying the decidable and complete data flow.

3450. The method of creating the computer language of aspect 3422 further comprising verifying the decidable and complete data flow.

3451. The method of creating the computer language of aspect 3423 further comprising verifying the decidable and complete data flow.

3452. The method of creating the computer language of aspect 3424 further comprising verifying the decidable and complete data flow.

3453. The method of creating the computer language of aspect 3425 further comprising verifying the decidable and complete data flow.

3454. The method of creating the computer language of aspect 3426 further comprising verifying the decidable and complete data flow.

3455. The method of creating the computer language of aspect 3427 further comprising verifying the decidable and complete data flow.

3456. The method of aspect 3428 wherein defining operators includes only specifying operators whose semantics are not ambiguous or result in infinite code paths.

3457. A computer language wherein a finite code path model can be generated for any program written in the language and a single algorithm exists for generating the finite code path model.

3458. The computer language of aspect 3457, wherein the computer language does not include operators having ambiguous semantics or operators capable of invoking infinite code paths.

3459. The computer language of aspect 3457, further including a plurality of operators wherein not one of the plurality of operators is capable of invoking an infinite code path in any of the set of all programs written in the computer language.

3460. The computer language of aspect 3459, wherein the infinite code path comprises an infinite loop.

3461. The computer language of aspect 3457 further including a plurality of operators wherein any one operator or any combination of operators of the plurality of operators cannot invoke an infinite or ambiguous code path.

3462. The computer language of aspect 3461, wherein the infinite or ambiguous code path comprises an infinite or ambiguous loop.

3463. The computer language of aspect 3457, further including a plurality of operators wherein no combination of operators of the plurality of operators are capable of invoking an infinite code path in any of the set of all programs written in the computer language.

3464. The computer language of aspect 3463, wherein the infinite code path comprises an infinite loop.

3465. The computer language of aspect 3457, wherein the computer language is a modified version of an existing language.

3466. The computer language of aspect 3465 wherein the existing language is one of C, C+, C++, Java, Basic, Pascal, and Fortran.

3467. The computer language of aspect 3457, wherein all programs comprise commercially useful programs having at least 1,000 lines of code.

3468. The computer language of aspect 3457, wherein all programs comprise programs having at least 1,000 lines of code.

3469. The computer language of aspect 3457, wherein all programs comprise commercially useful programs having at least 10,000 lines of code.

3470. The computer language of aspect 3457, wherein all programs comprise programs having at least 10,000 lines of code.

3471. The computer language of aspect 3457, wherein all programs comprise commercially useful programs having at least 100,000 lines of code.

3472. The computer language of aspect 3457, wherein all programs comprise programs having at least 100,000 lines of code.

3473. The computer language of aspect 3457, wherein all programs comprise commercially useful programs having at least 1,000,000 lines of code.

3474. The computer language of aspect 3457, wherein all programs comprise programs having at least 1,000,000 lines of code.

3475. A method of creating the computer language of aspect 3457 comprising: modifying an existing language by removing all operators of the language capable of invoking infinite code paths.

3476. A method of creating the computer language of aspect 3457 comprising: modifying an existing language by removing all operators (i) having ambiguous semantics and (ii) being capable of invoking infinite code paths.

3477. The method of aspect 3475, wherein the existing language is one of C, C+, C++, Java, Basic, Pascal, and Fortran.

3478. The method of aspect 3476, wherein the existing language is one of C, C+, C++, Java, Basic, Pascal, and Fortran.

3479. The method of aspect 3475, further comprising replacing the removed operators with one or more alternative operators incapable of invoking or ambiguous infinite loops.

3480. The method of aspect 3476, further comprising replacing the removed operators with one or more alternative operators incapable of invoking or ambiguous infinite loops.

3481. The method of aspect 3480 wherein a for loop operator is replaced with “sum” operator.

3482. A method of creating the computer language of aspect 3457 comprising modifying an existing computer language.

3483. The method of aspect 3482 wherein said modifying an existing an existing computer language comprises replacing operators capable of invoking infinite code paths with operators incapable of invoking infinite code paths.

3484. The method of aspect 3482 wherein said modifying an existing an existing computer language comprises replacing ambiguous operators with unambiguous operators.

3485. The method of aspect 3482 wherein said modifying an existing an existing computer language comprises replacing operators with ambiguous semantics with operators with unambiguous semantics.

3486. The method of aspect 3482, wherein said modifying an existing an existing computer language comprises redefining one or more data types.

3487. The method of aspect 3482, wherein said modifying an existing an existing computer language comprises replacing one or more data types.

3488. The method of aspect 3483, wherein said modifying an existing an existing computer language comprises redefining one or more data types.

3489. The method of aspect 3483, wherein said modifying an existing an existing computer language comprises replacing one or more data types.

3490. The method of aspect 3484, wherein said modifying an existing an existing computer language comprises redefining one or more data types.

3491. The method of aspect 3484, wherein said modifying an existing an existing computer language comprises replacing one or more data types.

3492. The method of aspect 3485, wherein said modifying an existing an existing computer language comprises redefining one or more data types.

3493. The method of aspect 3485, wherein said modifying an existing an existing computer language comprises replacing one or more data types.

3494. A method of creating the computer language of aspect 3457 comprising:
designing the language including defining operators and defining data types; and
verifying the decidable and complete data flow.

3495. The method of aspect 3494 wherein defining operators includes only specifying operators whose semantics are not ambiguous or cannot invoke infinite code paths.

3496. The method of aspect 3494 wherein the data types comprise enumerable and non-enumerable data types.

3497. The method of aspect 3496 wherein all data elements of the non-enumerated data types are represented as sets.

3498. The method of aspect 3497 wherein all data elements consisting of infinite sets are expressed with a finite lexical notation.

3499. The method of aspect 3497 wherein numeric data types are non-enumerated data types and numeric data elements of the numeric data types are expressed using equalities and/or inequalities.

3500. The method of aspect 3494 wherein verifying decidable and complete data flow comprises verifying both a code path quality and a data flow quality of the language.

3501. The method of aspect 3500 wherein said verifying a code path quality comprises demonstrating all possible code paths within the language can be expressed in a finite tree model.

3502. The method of aspect 3501, wherein the tree model comprises a directed acyclic graph.

3503. The method of aspect 3501 wherein said demonstrating all possible code paths within the language comprises generating a tree model using a tableau algorithm.

3504. The method of aspect 3500, wherein verifying the data flow quality further comprises identifying a set of one or more complete and correct algorithms that can determine the value of any data element in the set of all programs written in the language.

3505. The method of aspect 3504 wherein said identifying a set of one or more complete and correct algorithms comprises demonstrating a valid algorithm for each data type associated with the language.

3506. The method of aspect 3505, wherein said demonstrating a valid algorithm for each data type comprises utilizing automated algebraic analysis.

3507. The method of aspect 3505, wherein said demonstrating a valid algorithm for each data type comprises utilizing approximation.

3508. The method of aspect 3494, further comprising: repeating said designing the language after said verifying the decidable and complete data flow if decidable and complete data flow is unverifiable.

3509. The method of aspect 3508, wherein the operations of designing and verifying are repeated iteratively until decidable and complete data flow is verified.

3510. The method of creating the computer language of aspect 3482 further comprising verifying the decidable and complete data flow.

3511. The method of creating the computer language of aspect 3483 further comprising verifying the decidable and complete data flow.

3512. The method of creating the computer language of aspect 3484 further comprising verifying the decidable and complete data flow.

3513. The method of creating the computer language of aspect 3485 further comprising verifying the decidable and complete data flow.

3514. The method of creating the computer language of aspect 3486 further comprising verifying the decidable and complete data flow.

3515. The method of creating the computer language of aspect 3487 further comprising verifying the decidable and complete data flow.

3516. The method of creating the computer language of aspect 3488 further comprising verifying the decidable and complete data flow.

3517. The method of creating the computer language of aspect 3489 further comprising verifying the decidable and complete data flow.

3518. The method of creating the computer language of aspect 3490 further comprising verifying the decidable and complete data flow.

3519. The method of creating the computer language of aspect 3491 further comprising verifying the decidable and complete data flow.

3520. The method of creating the computer language of aspect 3492 further comprising verifying the decidable and complete data flow.

3521. The method of creating the computer language of aspect 3493 further comprising verifying the decidable and complete data flow.

3522. The method of aspect 3494 wherein defining operators includes only specifying operators whose semantics are not ambiguous or result in infinite code paths.

3523. A machine comprising:
means for generating a parse tree;
means for generating a code path set based on the parse tree;
means for generating a path data model set using the code path set; and
means for generating a finite input/output semantic model (FIOSM) from the path data model set.

3524. The machine of aspect 3523, wherein the means for generating a finite input/output semantic model dictates that the software has a completely decidable data flow.

3525. The machine of aspect 3523 wherein said means for generating a parse tree comprises means for parsing the source code of a software procedure.

3526. The machine of aspect 3523 wherein said means for generating a parse tree comprises means for parsing the source code of a software program.

3527. The machine of aspect 3523 wherein the parse tree comprises a directed acyclic graph structure (DAG).

3528. The machine of aspect 3525, wherein the source code is written in a FIOSM compliant programming language.

3529. The machine of aspect 3526, wherein the source code is written in a FIOSM compliant programming language.

3530. The machine of aspect 3523, wherein said means for generating a code path set based on the parse tree comprises means for utilizing a suitable algorithm to walk the parse tree.

3531. The machine of aspect 3523, wherein the code path set comprises condition free code path trees.

3532. The machine of aspect 3530, wherein the suitable algorithm comprises a tableau algorithm.

3533. The machine of aspect 3530, wherein the suitable algorithm comprises a book-marking algorithm.

3534. The machine of aspect 3523, wherein the path data model set comprises a plurality of logically consistent data element models.

3535. The machine of aspect 3534, wherein said means for generating a path data model set using the code path set includes means for discarding any logically inconsistent data element models.

3536. The machine of aspect 3523, wherein said means for generating a path data model set using the code path set comprises for each code path set element: (i) means for walking the code path parse tree of the code path set element; (ii) means for recording assignments and constraints for the code path set element.

3537. The machine of aspect 3523, wherein said means for generating a path data model set using the code path set comprises means for converting the code path set into a set of logically consistent data model elements.

3538. The machine of aspect 3523, wherein said means for generating a finite input/output semantic model (FIOSM) from the path data model set comprises: (i) means for identifying a set of input data elements in the program; (ii) means for identifying a set of output data elements; (iii) for each member of the path data model set, means for creating a input-output pattern expression; (iv) for each input data element, means for generating an input data expression and adding it to an input set; and (v) for each output data element, means for generating an output data expression and adding it to an output set.

3539. The machine of aspect 3538, wherein said means for formatting a FIOSM from the path data model set further comprises: means for eliminating intermediate data elements.

3540. A machine comprising means for generating a finite input output model (FIOSM) for a predetermined software program written in a FIOSM-compliant language.

3541. The machine of aspect 3540, further including means for creating a FIOSM compliant language.

3542. The machine of aspect 3540, further including means for causing the machine to modify an existing computer language to be an FIOSM compliant language.

3543. The machine of aspect 3540, further including means for modifying an existing non-FIOSM compliant computer language to be an FIOSM compliant language.

3544. The machine of aspect 3540, further including:
means for parsing the source code of the program to generate a parse tree;
means for generating a code path set using the parse tree;
means for generating a path data model set using the code path set; and
means for formatting a FIOSM from the path data model set.

3545. The machine of aspect 3540, wherein the FIOSM consists of all possible inputs to the software program and all possible outputs the software program can generate based on all possible inputs.

3546. The machine of aspect 3545, wherein the parse tree comprises a directed acyclic graph structure (DAG).

3547. The machine of aspect 3544, wherein the parse tree comprises a directed acyclic graph structure (DAG).

3548. The machine of aspect 3544, wherein the parse tree comprises a tree model

3549. The machine of aspect 3544 wherein the means for generating code path sets using the parse tree utilize a suitable algorithm to walk the parse tree.

3550. The machine of aspect 3549 wherein the suitable algorithm comprises a tableau algorithm.

3551. The machine of aspect 3549 wherein the suitable algorithm comprises a model search algorithm.

3552. The machine of aspect 3544 wherein the path data model set comprises a plurality of logically consistent data element models.

3553. The machine of aspect 3549 wherein means for generating a path data model set using the code path set include means for discarding any logically inconsistent data element models.

3554. The machine of aspect 3544 means for generating a path data model set using the code path sets further include for each code path set element means for: (i) walking the code path parse tree of the code path set element; (ii) recording assignments and constraints for the code path set element.

3555. The machine of aspect 3544 wherein the means for formatting a FIOSM from the path data model set include means for: (i) identifying a set of input data elements in the program; (ii) identify a set of output data elements; (iii) for each member of the path data model set, creating a input-output pattern expression; (iv) for each input data element, generating an input data expression and adding it to an input set; and (v) for each output data element, generating an output data expression and adding it to an output set.

3556. The machine of aspect 3555, wherein the means for formatting a FIOSM from the path data model set further includes means for eliminating intermediate data elements.

3557. A machine comprising means for employing a finite input/output semantic model (FIOSM).

3558. The machine of aspect 3557 wherein said means for employing a finite input/output semantic model further include means for designing a software programming language having decidable and complete dataflow wherein any and all software procedures created in the programming language can be represented by an FIOSM.

3559. The machine of aspect 3557 wherein said means for employing a finite input/output semantic model further include means for modifying an existing software programming language wherein any and all software procedures created in the programming language can be represented by an FIOSM.

3560. The machine of aspect 3559 wherein the existing software language comprises one of C, C+, C++, Java, Basic, Pascal, and Fortran.

3561. The machine of aspect 3559, wherein said means for modifying an existing software programming language further include means for removing all operators (i) having ambiguous semantics and (ii) being capable of invoking infinite code paths.

3562. The machine of aspect 3559, wherein said means for modifying an existing software programming language further include means for removing all operators capable of invoking infinite code paths.

3563. The machine of aspect 3561 wherein the existing software language comprises one of C, C+, C++, Java, Basic, Pascal, and Fortran.

3564. The machine of aspect 3562 wherein the existing software language comprises one of C, C+, C++, Java, Basic, Pascal, and Fortran.

3565. The machine of aspect 3561 further including means for replacing the removed operators with one or more alternative operators incapable of invoking infinite loops.

3566. The machine of aspect 3562 further including means for replacing the removed operators with one or more alternative operators incapable of invoking infinite loops.

3567. The machine of aspect 3563 further including means for replacing the removed operators with one or more alternative operators incapable of invoking infinite loops.

3568. The machine of aspect 3564 further including means for replacing the removed operators with one or more alternative operators incapable of invoking infinite loops.

3569. The machine of aspect 3561 further including means for replacing the removed operators with one or more alternative operators having unambiguous semantics.

3570. The machine of aspect 3562 further including means for replacing the removed operators with one or more alternative operators having unambiguous semantics.

3571. The machine of aspect 3563 further including means for replacing the removed operators with one or more alternative operators having unambiguous semantics.

3572. The machine of aspect 3564 further including means for replacing the removed operators with one or more alternative operators having unambiguous semantics.

3573. The machine of aspect 3561 including means for replacing a for loop operator with “sum” operator.

3574. The machine of aspect 3562 including means for replacing a for loop operator with “sum” operator.

3575. The machine of aspect 3563 including means for replacing a for loop operator with “sum” operator.

3576. The machine of aspect 3564 including means for replacing a for loop operator with “sum” operator.

3577. The machine of aspect 3559, wherein said means for modifying an existing software programming language includes means for redefining one or more data types.

3578. The machine of aspect 3559, wherein said means for modifying an existing software programming language include means for replacing one or more data types.

3579. The machine of aspect 3560, wherein said means for modifying an existing software programming language includes means for redefining one or more data types.

3580. The machine of aspect 3560, wherein said means for modifying an existing software programming language include means for replacing one or more data types.

3581. The machine of aspect 3561, wherein said means for modifying an existing software programming language includes means for redefining one or more data types.

3582. The machine of aspect 3561, wherein said means for modifying an existing software programming language include means for replacing one or more data types.

3583. The machine of aspect 3562, wherein said means for modifying an existing software programming language includes means for redefining one or more data types.

3584. The machine of aspect 3562, wherein said means for modifying an existing software programming language include means for replacing one or more data types.

3585. The machine of aspect 3563, wherein said means for modifying an existing software programming language includes means for redefining one or more data types.

3586. The machine of aspect 3563, wherein said means for modifying an existing software programming language include means for replacing one or more data types.

3587. The machine of aspect 3564, wherein said means for modifying an existing software programming language includes means for redefining one or more data types.

3588. The machine of aspect 3564, wherein said means for modifying an existing software programming language include means for replacing one or more data types.

3589. The machine of aspect 3565, wherein said means for modifying an existing software programming language includes means for redefining one or more data types.

3590. The machine of aspect 3565, wherein said means for modifying an existing software programming language include means for replacing one or more data types.

3591. The machine of aspect 3566, wherein said means for modifying an existing software programming language includes means for redefining one or more data types.

3592. The machine of aspect 3566, wherein said means for modifying an existing software programming language include means for replacing one or more data types.

3593. The machine of aspect 3567, wherein said means for modifying an existing software programming language includes means for redefining one or more data types.

3594. The machine of aspect 3567, wherein said means for modifying an existing software programming language include means for replacing one or more data types.

3595. The machine of aspect 3568, wherein said means for modifying an existing software programming language includes means for redefining one or more data types.

3596. The machine of aspect 3568, wherein said means for modifying an existing software programming language include means for replacing one or more data types.

3597. The machine of aspect 3569, wherein said means for modifying an existing software programming language includes means for redefining one or more data types.

3598. The machine of aspect 3569, wherein said means for modifying an existing software programming language include means for replacing one or more data types.

3599. The machine of aspect 3570, wherein said means for modifying an existing software programming language includes means for redefining one or more data types.

3600. The machine of aspect 3570, wherein said means for modifying an existing software programming language include means for replacing one or more data types.

3601. The machine of aspect 3571, wherein said means for modifying an existing software programming language includes means for redefining one or more data types.

3602. The machine of aspect 3571, wherein said means for modifying an existing software programming language include means for replacing one or more data types.

3603. The machine of aspect 3572, wherein said means for modifying an existing software programming language includes means for redefining one or more data types.

3604. The machine of aspect 3572, wherein said means for modifying an existing software programming language include means for replacing one or more data types.

3605. The machine of aspect 3558 wherein said means for designing a software programming language having decidable and complete dataflow include means for: (i) defining operators; and (ii) defining data types.

3606. The machine of aspect 3605 further including means stored thereon for: verifying the decidable and complete data flow.

3607. The machine of aspect 3605 wherein said means for defining operators include only specifying operators whose semantics are not ambiguous or cannot invoke infinite code paths.

3608. The machine of aspect 3606 wherein said instructions for defining operators includes only specifying operators whose semantics are not ambiguous or cannot invoke infinite code paths.

3609. The machine of aspect 3605 further including means for causing the machine to represent the data types as enumerable and non-enumerable data types.

3610. The machine of aspect 3605 further including means for representing all data elements of the non-enumerated data types as sets.

3611. The machine of aspect 3610 wherein means for representing all data elements of the non-enumerated data types as sets require that all data elements consisting of infinite sets are expressed with a finite lexical notation.

3612. The machine of aspect 3610 further including means for causing the machine to represent numeric data types are non-enumerated data types and express numeric data elements of the numeric data types using equalities and/or inequalities.

3613. The machine of aspect 3606 further including means for causing the machine to represent the data types as enumerable and non-enumerable data types.

3614. The machine of aspect 3606 further including means for representing all data elements of the non-enumerated data types as sets.

3615. The machine of aspect 3614 further including means for requiring that all data elements consisting of infinite sets are expressed with a finite lexical notation.

3616. The machine of aspect 3614 further including means for causing the machine to represent numeric data types are non-enumerated data types and express numeric data elements of the numeric data types using equalities and/or inequalities.

3617. The machine of aspect 3607 further including means for causing the one or more machine to represent the data types as enumerable and non-enumerable data types.

3618. The machine of aspect 3607 further including means for representing all data elements of the non-enumerated data types as sets.

3619. The machine of aspect 3618 further including means for requiring that all data elements consisting of infinite sets are expressed with a finite lexical notation.

3620. The machine of aspect 3618 further including means for causing the machine to represent numeric data types are non-enumerated data types and express numeric data elements of the numeric data types using equalities and/or inequalities.

3621. The machine of aspect 3608 further including means for causing the one or more machine to represent the data types as enumerable and non-enumerable data types.

3622. The machine of aspect 3608 further including means for representing all data elements of the non-enumerated data types as sets.

3623. The machine of aspect 3622 wherein all data elements consisting of infinite sets are expressed with a finite lexical notation when executed on the machine.

3624. The machine of aspect 3622 including means for causing the machine to represent numeric data types are non-enumerated data types and express numeric data elements of the numeric data types using equalities and/or inequalities.

3625. The machine of aspect 3606 wherein said means for verifying decidable and complete data flow include means for verifying both a code path quality and a data flow quality of the language.

3626. The machine of aspect 3625 wherein said means for verifying a code path quality include means for demonstrating all possible code paths within the language can be expressed in a finite tree model.

3627. The machine of aspect 3626, wherein the tree model comprises a directed acyclic graph.

3628. The machine of aspect 3626, wherein said means for demonstrating all possible code paths within the language include means for generating a tree model using a tableau algorithm.

3629. The machine of aspect 3626, wherein said means for demonstrating all possible code paths within the language include means for generating a tree model using a model search algorithm.

3630. The machine of aspect 3625, wherein means for verifying the data flow quality further include means for identifying a set of one or more complete and correct algorithms that can determine the value of any data element in the set of all programs written in the language.

3631. The machine of aspect 3630 wherein means for identifying a set of one or more complete and correct algorithms include means for demonstrating a valid algorithm for each data type associated with the language.

3632. The machine of aspect 3631, wherein means for demonstrating a valid algorithm for each data type include means for utilizing automated algebraic analysis.

3633. The machine of aspect 3631, wherein means for demonstrating a valid algorithm for each data type include means for utilizing approximation.

3634. The machine of aspect 3606, further including means that when executed on the machine cause the machines to: repeat said designing the language after said verifying the decidable and complete data flow if decidable and complete data flow is unverifiable.

3635. The machine of aspect 3563, wherein the means for the operations of designing and verifying are executed by the machine repeatedly until decidable and complete data flow is verified.

3636. The machine of aspect 3557 wherein means for employing a finite input/output semantic model include means for generating a software procedure and a corresponding FIOSM for the software procedure.

3637. The machine of aspect 3557 wherein means for employing a finite input/output semantic model include means for generating a software routine and a corresponding FIOSM for the software routine.

3638. The machine of aspect 3557 wherein means for employing a finite input/output semantic model include means for generating a software program and a corresponding FIOSM for the software program.

3639. The machine of aspect 3557 wherein means for employing a finite input/output semantic model include means for generating a software module and a corresponding FIOSM for the software module.

3640. The machine of aspect 3557 wherein means for employing a finite input/output semantic model include means for generating a software enterprise system and a corresponding FIOSM for the software enterprise system.

3641. A machine comprising:
a means for receiving a source program;
a means for parsing the source program into an abstract data structure;
a means for generating a set of code paths based on the abstract data structure;
a means for converting the set of code paths into a set of logically consistent data element models;
a means for utilizing the set of logically consistent data element models to format the finite input/output semantic model including:
   a means for identifying a set of input data elements in the source program,
   a means for identifying a set of output data elements in the source program, and for each set of data elements, creating an input-output pattern expression;
   a means for producing a valid data expression for each set of input data elements; and
   a means for producing a valid data expression for each set of output data elements.

3642. The machine of aspect 3641 wherein the abstract data structure comprises a parse tree.

3643. The machine of aspect 3641 wherein the abstract data structure comprises a tree model

3644. The machine of aspect 3641 wherein the abstract data structure comprises a directed acyclic graph structure.

3645. The machine of aspect 3642 wherein means for generating a set of code paths based on the abstract data structure include means for walking the parse tree.

3646. The machine of aspect 3642 wherein means for generating a set of code paths based on the abstract data structure include means for using a suitable algorithm to walk the parse tree.

3647. The machine of aspect 3646 wherein the suitable algorithm is a model-splitting type algorithm.

3648. The machine of aspect 3647 wherein the model-splitting type algorithm is a member of the Tableau family of algorithms.

3649. The machine of aspect 3646 wherein the suitable algorithm is a book-marking type algorithm.

3650. The machine of aspect 3646 wherein the suitable algorithm is a model search algorithm.

3651. The machine of aspect 3641 wherein each data element model of the set of logically consistent data element models represents one input-output pattern of the source program.

3652. The machine of aspect 3641, wherein means for converting the set of code paths into a set of logically consistent data element models include means for discarding logically inconsistent data element models from the set of code paths.

3653. The machine of aspect 3641, wherein means for converting the set of code paths into a set of logically consistent data element models include means for (i) walking the set of code paths, (ii) generating the set of data element models, and (iii) testing each data element model of the set for data-element consistency.

3654. A machine comprising:
a means for specifying a known programming language; and
a means for modifying the language wherein any program written in the language is finite input output semantic model compliant.

3655. The machine of aspect 3654 wherein the known programming language comprises one of: C, C+, C++, Java, Basic, Pascal, and Fortran.

3656. The machine of aspect 3654, wherein means for modifying language include means for removing all operators (i) having ambiguous semantics and (ii) being capable of invoking infinite code paths.

3657. The machine of aspect 3655, wherein means for modifying language include means for removing all operators (i) having ambiguous semantics and (ii) being capable of invoking infinite code paths.

3658. The machine of aspect 3654, wherein means for modifying an existing software programming language include means for removing all operators capable of invoking infinite code paths.

3659. The machine of aspect 3655, wherein means for modifying an existing software programming language include means for removing all operators capable of invoking infinite code paths.

3660. The machine of aspect 3656 further including a means for replacing the removed operators with one or more alternative operators incapable of invoking infinite loops.

3661. The machine of aspect 3657 including a means for replacing the removed operators with one or more alternative operators incapable of invoking infinite loops.

3662. The machine of aspect 3658 including a means for replacing the removed operators with one or more alternative operators incapable of invoking infinite loops.

3663. The machine of aspect 3659 including a means for replacing the removed operators with one or more alternative operators incapable of invoking infinite loops.

3664. The machine of aspect 3656 including a means for replacing the removed operators with one or more alternative operators having unambiguous semantics.

3665. The machine of aspect 3657 including a means for replacing the removed operators with one or more alternative operators having unambiguous semantics.

3666. The machine of aspect 3658 including a means for replacing the removed operators with one or more alternative operators having unambiguous semantics.

3667. The machine of aspect 3659 including a means for replacing the removed operators with one or more alternative operators having unambiguous semantics.

3668. The machine of aspect 3656 including a means for replacing a for loop operator with “sum” operator.

3669. The machine of aspect 3657 including a means for replacing a for loop operator with “sum” operator.

3670. The machine of aspect 3658 including a means for replacing a for loop operator with “sum” operator.

3671. The machine of aspect 3659 including a means for replacing a for loop operator with “sum” operator.

3672. The machine of aspect 3660 including a means for replacing a for loop operator with “sum” operator.

3673. The machine of aspect 3661 including a means for replacing a for loop operator with “sum” operator.

3674. The machine of aspect 3662 including a means for replacing a for loop operator with “sum” operator.

3675. The machine of aspect 3663 including a means for replacing a for loop operator with “sum” operator.

3676. The machine of aspect 3664 including a means for replacing a for loop operator with “sum” operator.

3677. The machine of aspect 3665 including a means for replacing a for loop operator with “sum” operator.

3678. The machine of aspect 3666 including a means for replacing a for loop operator with “sum” operator.

3679. The machine of aspect 3667 including a means for replacing a for loop operator with “sum” operator.

3680. The machine of aspect 3654, wherein means for modifying the language include means for redefining one or more data types.

3681. The machine of aspect 3654, wherein means for modifying the language include means for replacing one or more data types.

3682. The machine of aspect 3655, wherein means for modifying the language include means for redefining one or more data types.

3683. The machine of aspect 3655, wherein means for modifying the language include means for replacing one or more data types.

3684. The machine of aspect 3656, wherein means for modifying the language include means for redefining one or more data types.

3685. The machine of aspect 3656, wherein means for modifying the language include means for replacing one or more data types.

3686. The machine of aspect 3657, wherein means for modifying the language include means for redefining one or more data types.

3687. The machine of aspect 3657, wherein means for modifying the language include means for replacing one or more data types.

3688. The machine of aspect 3658, wherein means for modifying the language include means for redefining one or more data types.

3689. The machine of aspect 3658, wherein means for modifying the language include means for replacing one or more data types.

3690. The machine of aspect 3659, wherein means for modifying the language include means for redefining one or more data types.

3691. The machine of aspect 3659, wherein means for modifying the language include means for replacing one or more data types.

3692. The machine of aspect 3660, wherein means for modifying the language include means for redefining one or more data types.

3693. The machine of aspect 3660, wherein means for modifying the language include means for replacing one or more data types.

3694. The machine of aspect 3661, wherein means for modifying the language include means for redefining one or more data types.

3695. The machine of aspect 3661, wherein means for modifying the language include means for replacing one or more data types.

3696. The machine of aspect 3662, wherein means for modifying the language include means for redefining one or more data types.

3697. The machine of aspect 3662, wherein means for modifying the language include means for replacing one or more data types.

3698. The machine of aspect 3663, wherein means for modifying the language include means for redefining one or more data types.

3699. The machine of aspect 3663, wherein means for modifying the language include means for replacing one or more data types.

3700. The machine of aspect 3664, wherein means for modifying the language include means for redefining one or more data types.

3701. The machine of aspect 3664, wherein means for modifying the language include means for replacing one or more data types.

3702. The machine of aspect 3665, wherein means for modifying the language include means for redefining one or more data types.

3703. The machine of aspect 3665, wherein means for modifying the language include means for replacing one or more data types.

3704. The machine of aspect 3666, wherein means for modifying the language include means for redefining one or more data types.

3705. The machine of aspect 3666, wherein means for modifying the language include means for replacing one or more data types.

3706. The machine of aspect 3667, wherein means for modifying the language include means for redefining one or more data types.

3707. The machine of aspect 3667, wherein means for modifying the language include means for replacing one or more data types.

3708. The machine of aspect 3668, wherein means for modifying the language include means for redefining one or more data types.

3709. The machine of aspect 3668, wherein means for modifying the language include means for replacing one or more data types.

3710. The machine of aspect 3669, wherein means for modifying the language include means for redefining one or more data types.

3711. The machine of aspect 3669, wherein means for modifying the language include means for replacing one or more data types.

3712. The machine of aspect 3670, wherein means for modifying the language include means for redefining one or more data types.

3713. The machine of aspect 3670, wherein means for modifying the language include means for replacing one or more data types.

3714. The machine of aspect 3671, wherein means for modifying the language include means for redefining one or more data types.

3715. The machine of aspect 3671, wherein means for modifying the language include means for replacing one or more data types.

3716. The machine of aspect 3672, wherein means for modifying the language include means for redefining one or more data types.

3717. The machine of aspect 3672, wherein means for modifying the language include means for replacing one or more data types.

3718. The machine of aspect 3673, wherein means for modifying the language include means for redefining one or more data types.

3719. The machine of aspect 3673, wherein means for modifying the language include means for replacing one or more data types.

3720. The machine of aspect 3674, wherein means for modifying the language include means for redefining one or more data types.

3721. The machine of aspect 3674, wherein means for modifying the language include means for replacing one or more data types.

3722. The machine of aspect 3675, wherein means for modifying the language include means for redefining one or more data types.

3723. The machine of aspect 3675, wherein means for modifying the language include means for replacing one or more data types.

3724. The machine of aspect 3676, wherein means for modifying the language include means for redefining one or more data types.

3725. The machine of aspect 3676, wherein means for modifying the language include means for replacing one or more data types.

3726. The machine of aspect 3677, wherein means for modifying the language include means for redefining one or more data types.

3727. The machine of aspect 3677, wherein means for modifying the language include means for replacing one or more data types.

3728. The machine of aspect 3678, wherein means for modifying the language include means for redefining one or more data types.

3729. The machine of aspect 3678, wherein means for modifying the language include means for replacing one or more data types.

3730. The machine of aspect 3679, wherein means for modifying the language include means for redefining one or more data types.

3731. The machine of aspect 3679, wherein means for modifying the language include means for replacing one or more data types.

3732. The machine of aspect 3654 further comprising means for verifying that all programs created in the language have decidable and complete data flow.

3733. A machine comprising:
means for specifying a known programming language; and
means for modifying the language wherein the modified language satisfies both a finite code path property and a data flow property.

3734. The machine of aspect 3733 further comprising means for verifying compliance with the finite code path property.

3735. The machine of aspect 3733 further comprising means for verifying compliance with the data flow property.

3736. The machine of aspect 3734 further comprising means for verifying compliance with the data flow property.

3737. The machine of aspect 3733 wherein said means for modifying the language includes means for redefining one or more data types.

3738. The machine of aspect 3734 wherein said means for modifying the language includes means for redefining one or more data types.

3739. The machine of aspect 3735 wherein said means for modifying the language includes means for redefining one or more data types.

3740. The machine of aspect 3736 wherein said means for modifying the language includes means for redefining one or more data types.

3741. The machine of aspect 3733 wherein said means for modifying the language includes means for replacing one or more operators having ambiguous semantics with replacement operators having unambiguous semantics.

3742. The machine of aspect 3734 wherein said means for modifying the language includes means for replacing one or more operators having ambiguous semantics with replacement operators having unambiguous semantics.

3743. The machine of aspect 3735 wherein said means for modifying the language includes means for replacing one or more operators having ambiguous semantics with replacement operators having unambiguous semantics.

3744. The machine of aspect 3736 wherein said means for modifying the language includes means for replacing one or more operators having ambiguous semantics with replacement operators having unambiguous semantics.

3745. The machine of aspect 3737 wherein said means for modifying the language includes means for replacing one or more operators having ambiguous semantics with replacement operators having unambiguous semantics.

3746. The machine of aspect 3738 wherein said means for modifying the language includes means for replacing one or more operators having ambiguous semantics with replacement operators having unambiguous semantics.

3747. The machine of aspect 3739 wherein said means for modifying the language includes means for replacing one or more operators having ambiguous semantics with replacement operators having unambiguous semantics.

3748. The machine of aspect 3740 wherein said means for modifying the language includes means for replacing one or more operators having ambiguous semantics with replacement operators having unambiguous semantics.

3749. The machine of aspect 3737 wherein the redefined data types comprise enumerable and non-enumerable data types.

3750. The machine of aspect 3738 wherein the redefined data types comprise enumerable and non-enumerable data types.

3751. The machine of aspect 3739 wherein the redefined data types comprise enumerable and non-enumerable data types.

3752. The machine of aspect 3740 wherein the redefined data types comprise enumerable and non-enumerable data types.

3753. The machine of aspect 3737 wherein the redefined data types comprise enumerable and non-enumerable data types.

3754. The machine of aspect 3749 wherein all data elements of the non-enumerated data types are represented as sets.

3755. The machine of aspect 3750 wherein all data elements of the non-enumerated data types are represented as sets.

3756. The machine of aspect 3751 wherein all data elements of the non-enumerated data types are represented as sets.

3757. The machine of aspect 3752 wherein all data elements of the non-enumerated data types are represented as sets.

3758. The machine of aspect 3753 wherein all data elements of the non-enumerated data types are represented as sets.

3759. The machine of aspect 3754 wherein all data elements consisting of infinite sets are expressed with a finite lexical notation.

3760. The machine of aspect 3755 wherein all data elements consisting of infinite sets are expressed with a finite lexical notation.

3761. The machine of aspect 3756 wherein all data elements consisting of infinite sets are expressed with a finite lexical notation.

3762. The machine of aspect 3757 wherein all data elements consisting of infinite sets are expressed with a finite lexical notation.

3763. The machine of aspect 3758 wherein all data elements consisting of infinite sets are expressed with a finite lexical notation.

3764. The machine of aspect 3754 wherein numeric data types are non-enumerated data types and numeric data elements of the numeric data types are expressed using equalities and/or inequalities.

3765. The machine of aspect 3755 wherein numeric data types are non-enumerated data types and numeric data elements of the numeric data types are expressed using equalities and/or inequalities.

3766. The machine of aspect 3756 wherein numeric data types are non-enumerated data types and numeric data elements of the numeric data types are expressed using equalities and/or inequalities.

3767. The machine of aspect 3757 wherein numeric data types are non-enumerated data types and numeric data elements of the numeric data types are expressed using equalities and/or inequalities.

3768. The machine of aspect 3758 wherein numeric data types are non-enumerated data types and numeric data elements of the numeric data types are expressed using equalities and/or inequalities.

3769. The machine of aspect 3734 wherein said means for verifying compliance with the finite code path property includes means for demonstrating all possible code paths within the language can be expressed in a finite tree model.

3770. The machine of aspect 3769, wherein the tree model comprises a directed acyclic graph.

3771. The machine of aspect 3770 wherein said means for demonstrating all possible code paths within the language includes means for generating a tree model using a tableau algorithm.

3772. The machine of aspect 3769 wherein said means for demonstrating all possible code paths within the language includes means for generating a tree model using a tableau algorithm.

3773. The machine of aspect 3769 wherein said demonstrating all possible code paths within the language includes generating a tree model using a model search algorithm.

3774. The machine of aspect 3735 wherein said means for verifying compliance with the finite code path property includes means for demonstrating all possible code paths within the language can be expressed in a finite tree model.

3775. The machine of aspect 3774, wherein the tree model comprises a directed acyclic graph.

3776. The machine of aspect 3775 wherein said means for demonstrating all possible code paths within the language includes means for generating a tree model using a tableau algorithm.

3777. The machine of aspect 3747 wherein said means for demonstrating all possible code paths within the language includes means for generating a tree model using a tableau algorithm.

3778. The machine of aspect 3747 wherein said means for demonstrating all possible code paths within the language includes means for generating a tree model using a model search algorithm.

3779. The machine of aspect 3736 wherein said means for verifying compliance with the finite code path property includes means for demonstrating all possible code paths within the language can be expressed in a finite tree model.

3780. The machine of aspect 3779, wherein the tree model comprises a directed acyclic graph.

3781. The machine of aspect 3780 wherein said means for demonstrating all possible code paths within the language includes means for generating a tree model using a tableau algorithm.

3782. The machine of aspect 3779 wherein said means for demonstrating all possible code paths within the language includes means for generating a tree model using a tableau algorithm.

3783. The machine of aspect 3779 wherein said means for demonstrating all possible code paths within the language includes means for generating a tree model using a model search algorithm.

3784. The machine of aspect 3735, wherein said means for verifying compliance with the data flow property includes means for identifying a set of one or more complete and correct algorithms that can determine the value of any data element in the set of all programs written in the language.

3785. The machine of aspect 3784 wherein said means for identifying a set of one or more complete and correct algorithms includes means for demonstrating a valid algorithm for each data type associated with the language.

3786. The machine of aspect 3785, wherein said means for demonstrating a valid algorithm for each data type includes means for utilizing automated algebraic analysis.

3787. The machine of aspect 3785, wherein said means for demonstrating a valid algorithm for each data type includes means for utilizing approximation.

3788. The machine of aspect 3739, wherein said means for verifying compliance with the data flow property includes means for identifying a set of one or more complete and correct algorithms that can determine the value of any data element in the set of all programs written in the language.

3789. The machine of aspect 3788 wherein said means for identifying a set of one or more complete and correct algorithms includes means for demonstrating a valid algorithm for each data type associated with the language.

3790. The machine of aspect 3789, wherein said means for demonstrating a valid algorithm for each data type includes means for utilizing automated algebraic analysis.

3791. The machine of aspect 3789, wherein said means for demonstrating a valid algorithm for each data type includes means for utilizing approximation.

3792. The machine of aspect 3743, wherein said means for verifying compliance with the data flow property includes means for identifying a set of one or more complete and correct algorithms that can determine the value of any data element in the set of all programs written in the language.

3793. The machine of aspect 3792 wherein said means for identifying a set of one or more complete and correct algorithms includes means for demonstrating a valid algorithm for each data type associated with the language.

3794. The machine of aspect 3793, wherein said means for demonstrating a valid algorithm for each data type includes means for utilizing automated algebraic analysis.

3795. The machine of aspect 3793, wherein said means for demonstrating a valid algorithm for each data type includes means for utilizing approximation.

3796. A means for employing a finite input/output semantic model (FIOSM).

3797. A means for modifying the language wherein any program written in the language is finite input output semantic model compliant.

3798. A means for modifying the language wherein the modified language satisfies both a finite code path property and a data flow property.

3799. A machine for creating a computer language wherein a set of all programs created in the language have a decidable and complete data flow, the machine comprising:
means for designing the language including defining operators and defining data types; and
means for verifying the decidable and complete data flow.

3800. The machine of aspect 3799, wherein said means for verifying the decidable and complete data flow further includes a means for generating a FIOSM for the computer language.

3801. A machine comprising:
means for designing the language including defining operators and defining data types; and
means for verifying an FIOSM can be generated for all programs created in the language by verifying all programs have decidable and complete data flow.

3802. A machine comprising:
means for designing a software language including defining a set of all operators and defining a set of data types; and
means for verifying that each operator of the set of operators is incapable of invoking an infinite loop.

3803. A method of creating the computer language wherein each operator of a set consisting of all operators in the language is incapable of invoking an infinite code path, the method comprising:
designing the language including defining the set of all operators and defining a set of data types; and
verifying that each operator of the set of operators is incapable of invoking an infinite loop.

3804. A machine comprising:
means for creating a finite input output semantic model (FIOSM) compliant programming language;
means for generating a software program in the FIOSM compliant language; and
means for generating a FIOSM for the program.

3805. A machine comprising:
means for creating a finite input output semantic model (FIOSM) compliant programming language;
means for generating a software procedure in the FIOSM compliant language; and
means for generating a FIOSM for the procedure.

3806. A machine comprising:
means for creating a finite input output semantic model (FIOSM) compliant programming language;
means for generating a software routine in the FIOSM compliant language; and
means for generating a FIOSM for the routine.

3807. A machine comprising:
means for creating a finite input output semantic model (FIOSM) compliant programming language;
means for generating a software enterprise system in the FIOSM compliant language; and
means for generating a FIOSM for the enterprise system.

3808. A machine comprising:
means for designing a programming language;
means for defining a finite input output semantic model for the programming language; and
means for verifying code path and data flow qualities of the programming language.

3809. A machine comprising means for representing a software program having fully decidable data flow in a parse tree.

3810. A machine comprising means for representing a software procedure having fully decidable data flow in a parse tree.

3811. A machine comprising means for representing a software routine having fully decidable data flow in a parse tree.

3812. A machine comprising means for representing a software module having fully decidable data flow in a parse tree.

3813. A machine comprising means for representing a software enterprise system having fully decidable data flow in a parse tree.

3814. A machine comprising:
means for generating a finite input/output semantic model for a software procedure; and
means for using the model for ensuring quality of the software procedure.

3815. A means of automating software quality control utilizing a finite input/output semantic model.

3816. A means of automating software quality control based on a finite input/output semantic model of the software.

3817. A system comprising:
means for generating a parse tree;
means for generating a code path set based on the parse tree;
means for generating a path data model set using the code path set; and
means for generating a finite input/output semantic model (FIOSM) from the path data model set.

3818. The system of aspect 3817, wherein the means for generating a finite input/output semantic model dictates that the software has a completely decidable data flow.

3819. The system of aspect 3817 wherein said means for generating a parse tree comprises means for parsing the source code of a software procedure.

3820. The system of aspect 3817 wherein said means for generating a parse tree comprises means for parsing the source code of a software program.

3821. The system of aspect 3817 wherein the parse tree comprises a directed acyclic graph structure (DAG).

3822. The system of aspect 3819, wherein the source code is written in a FIOSM compliant programming language.

3823. The system of aspect 3820, wherein the source code is written in a FIOSM compliant programming language.

3824. The system of aspect 3817, wherein said means for generating a code path set based on the parse tree comprises means for utilizing a suitable algorithm to walk the parse tree.

3825. The system of aspect 3817, wherein the code path set comprises condition free code path trees.

3826. The system of aspect 3824, wherein the suitable algorithm comprises a tableau algorithm.

3827. The system of aspect 3824, wherein the suitable algorithm comprises a book-marking algorithm.

3828. The system of aspect 3817, wherein the path data model set comprises a plurality of logically consistent data element models.

3829. The system of aspect 3828, wherein said means for generating a path data model set using the code path set includes means for discarding any logically inconsistent data element models.

3830. The system of aspect 3817, wherein said means for generating a path data model set using the code path set comprises for each code path set element: (i) means for walking the code path parse tree of the code path set element; (ii) means for recording assignments and constraints for the code path set element.

3831. The system of aspect 3817, wherein said means for generating a path data model set using the code path set comprises means for converting the code path set into a set of logically consistent data model elements.

3832. The system of aspect 3817, wherein said means for generating a finite input/output semantic model (FIOSM) from the path data model set comprises: (i) means for identifying a set of input data elements in the program; (ii) means for identifying a set of output data elements; (iii) for each member of the path data model set, means for creating a input-output pattern expression; (iv) for each input data element, means for generating an input data expression and adding it to an input set; and (v) for each output data element, means for generating an output data expression and adding it to an output set.

3833. The system of aspect 3832, wherein said means for formatting a FIOSM from the path data model set further comprises: means for eliminating intermediate data elements.

3834. A system comprising means for generating a finite input output model (FIOSM) for a predetermined software program written in an FIOSM-compliant language.

3835. The system of aspect 3834, further including means for creating a FIOSM compliant language.

3836. The system of aspect 3834, further including means for causing the system to modify an existing computer language to be an FIOSM compliant language.

3837. The system of aspect 3834, further including means for modifying an existing non-FIOSM compliant computer language to be an FIOSM compliant language.

3838. The system of aspect 3834, further including:
means for parsing the source code of the program to generate a parse tree;
means for generating a code path set using the parse tree;
means for generating a path data model set using the code path set; and
means for formatting a FIOSM from the path data model set.

3839. The system of aspect 3834, wherein the FIOSM consists of all possible inputs to the software program and all possible outputs the software program can generate based on all possible inputs.

3840. The system of aspect 3839, wherein the parse tree comprises a directed acyclic graph structure (DAG).

3841. The system of aspect 3838, wherein the parse tree comprises a directed acyclic graph structure (DAG).

3842. The system of aspect 3838, wherein the parse tree comprises a tree model

3843. The system of aspect 3838 wherein the means for generating code path sets using the parse tree utilize a suitable algorithm to walk the parse tree.

3844. The system of aspect 3843 wherein the suitable algorithm comprises a tableau algorithm.

3845. The system of aspect 3843 wherein the suitable algorithm comprises a model search algorithm.

3846. The system of aspect 3838 wherein the path data model set comprises a plurality of logically consistent data element models.

3847. The system of aspect 3843 wherein means for generating a path data model set using the code path set include means for discarding any logically inconsistent data element models.

3848. The system of aspect 3838 means for generating a path data model set using the code path sets further include for each code path set element means for: (i) walking the code path parse tree of the code path set element; (ii) recording assignments and constraints for the code path set element.

3849. The system of aspect 3838 wherein the means for formatting a FIOSM from the path data model set include means for: (i) identifying a set of input data elements in the program; (ii) identify a set of output data elements; (iii) for each member of the path data model set, creating a input-output pattern expression; (iv) for each input data element, generating an input data expression and adding it to an input set; and (v) for each output data element, generating an output data expression and adding it to an output set.

3850. The system of aspect 3849, wherein the means for formatting a FIOSM from the path data model set further includes means for eliminating intermediate data elements.

3851. A system comprising means for employing a finite input/output semantic model (FIOSM).

3852. The system of aspect 3851 wherein said means for employing a finite input/output semantic model further include means for designing a software programming language having decidable and complete dataflow wherein any and all software procedures created in the programming language can be represented by an FIOSM.

3853. The system of aspect 3851 wherein said means for employing a finite input/output semantic model further include means for modifying an existing software programming language wherein any and all software procedures created in the programming language can be represented by an FIOSM.

3854. The system of aspect 3853 wherein the existing software language comprises one of C, C+, C++, Java, Basic, Pascal, and Fortran.

3855. The system of aspect 3853, wherein said means for modifying an existing software programming language further include means for removing all operators (i) having ambiguous semantics and (ii) being capable of invoking infinite code paths.

3856. The system of aspect 3853, wherein said means for modifying an existing software programming language further include means for removing all operators capable of invoking infinite code paths.

3857. The system of aspect 3855 wherein the existing software language comprises one of C, C+, C++, Java, Basic, Pascal, and Fortran.

3858. The system of aspect 3856 wherein the existing software language comprises one of C, C+, C++, Java, Basic, Pascal, and Fortran.

3859. The system of aspect 3855 further including means for replacing the removed operators with one or more alternative operators incapable of invoking infinite loops.

3860. The system of aspect 3856 further including means for replacing the removed operators with one or more alternative operators incapable of invoking infinite loops.

3861. The system of aspect 3857 further including means for replacing the removed operators with one or more alternative operators incapable of invoking infinite loops.

3862. The system of aspect 3858 further including means for replacing the removed operators with one or more alternative operators incapable of invoking infinite loops.

3863. The system of aspect 3855 further including means for replacing the removed operators with one or more alternative operators having unambiguous semantics.

3864. The system of aspect 3856 further including means for replacing the removed operators with one or more alternative operators having unambiguous semantics.

3865. The system of aspect 3857 further including means for replacing the removed operators with one or more alternative operators having unambiguous semantics.

3866. The system of aspect 3858 further including means for replacing the removed operators with one or more alternative operators having unambiguous semantics.

3867. The system of aspect 3855 including means for replacing a for loop operator with “sum” operator.

3868. The system of aspect 3856 including means for replacing a for loop operator with “sum” operator.

3869. The system of aspect 3857 including means for replacing a for loop operator with “sum” operator.

3870. The system of aspect 3858 including means for replacing a for loop operator with “sum” operator.

3871. The system of aspect 3853, wherein said means for modifying an existing software programming language includes means for redefining one or more data types.

3872. The system of aspect 3853, wherein said means for modifying an existing software programming language include means for replacing one or more data types.

3873. The system of aspect 3854, wherein said means for modifying an existing software programming language includes means for redefining one or more data types.

3874. The system of aspect 3854, wherein said means for modifying an existing software programming language include means for replacing one or more data types.

3875. The system of aspect 3855, wherein said means for modifying an existing software programming language includes means for redefining one or more data types.

3876. The system of aspect 3855, wherein said means for modifying an existing software programming language include means for replacing one or more data types.

3877. The system of aspect 3856, wherein said means for modifying an existing software programming language includes means for redefining one or more data types.

3878. The system of aspect 3856, wherein said means for modifying an existing software programming language include means for replacing one or more data types.

3879. The system of aspect 3857, wherein said means for modifying an existing software programming language includes means for redefining one or more data types.

3880. The system of aspect 3857, wherein said means for modifying an existing software programming language include means for replacing one or more data types.

3881. The system of aspect 3858, wherein said means for modifying an existing software programming language includes means for redefining one or more data types.

3882. The system of aspect 3858, wherein said means for modifying an existing software programming language include means for replacing one or more data types.

3883. The system of aspect 3859, wherein said means for modifying an existing software programming language includes means for redefining one or more data types.

3884. The system of aspect 3859, wherein said means for modifying an existing software programming language include means for replacing one or more data types.

3885. The system of aspect 3860, wherein said means for modifying an existing software programming language includes means for redefining one or more data types.

3886. The system of aspect 3860, wherein said means for modifying an existing software programming language include means for replacing one or more data types.

3887. The system of aspect 3861, wherein said means for modifying an existing software programming language includes means for redefining one or more data types.

3888. The system of aspect 3861, wherein said means for modifying an existing software programming language include means for replacing one or more data types.

3889. The system of aspect 3862, wherein said means for modifying an existing software programming language includes means for redefining one or more data types.

3890. The system of aspect 3862, wherein said means for modifying an existing software programming language include means for replacing one or more data types.

3891. The system of aspect 3863, wherein said means for modifying an existing software programming language includes means for redefining one or more data types.

3892. The system of aspect 3863, wherein said means for modifying an existing software programming language include means for replacing one or more data types.

3893. The system of aspect 3864, wherein said means for modifying an existing software programming language includes means for redefining one or more data types.

3894. The system of aspect 3864, wherein said means for modifying an existing software programming language include means for replacing one or more data types.

3895. The system of aspect 3865, wherein said means for modifying an existing software programming language includes means for redefining one or more data types.

3896. The system of aspect 3865, wherein said means for modifying an existing software programming language include means for replacing one or more data types.

3897. The system of aspect 3866, wherein said means for modifying an existing software programming language includes means for redefining one or more data types.

3898. The system of aspect 3866, wherein said means for modifying an existing software programming language include means for replacing one or more data types.

3899. The system of aspect 3852 wherein said means for designing a software programming language having decidable and complete dataflow include means for: (i) defining operators; and (ii) defining data types.

3900. The system of aspect 3899 further including means stored thereon for: verifying the decidable and complete data flow.

3901. The system of aspect 3899 wherein said means for defining operators include only specifying operators whose semantics are not ambiguous or cannot invoke infinite code paths.

3902. The system of aspect 3900 wherein said instructions for defining operators includes only specifying operators whose semantics are not ambiguous or cannot invoke infinite code paths.

3903. The system of aspect 3899 further including means for causing the system to represent the data types as enumerable and non-enumerable data types.

3904. The system of aspect 3899 further including means for representing all data elements of the non-enumerated data types as sets.

3905. The system of aspect 3904 wherein means for representing all data elements of the non-enumerated data types as sets require that all data elements consisting of infinite sets are expressed with a finite lexical notation.

3906. The system of aspect 3904 further including means for causing the system to represent numeric data types are non-enumerated data types and express numeric data elements of the numeric data types using equalities and/or inequalities.

3907. The system of aspect 3900 further including means for causing the system to represent the data types as enumerable and non-enumerable data types.

3908. The system of aspect 3900 further including means for representing all data elements of the non-enumerated data types as sets.

3909. The system of aspect 3908 further including means for requiring that all data elements consisting of infinite sets are expressed with a finite lexical notation.

3910. The system of aspect 3908 further including means for causing the system to represent numeric data types are non-enumerated data types and express numeric data elements of the numeric data types using equalities and/or inequalities.

3911. The system of aspect 3901 further including means for causing the one or more system to represent the data types as enumerable and non-enumerable data types.

3912. The system of aspect 3901 further including means for representing all data elements of the non-enumerated data types as sets.

3913. The system of aspect 3912 further including means for requiring that all data elements consisting of infinite sets are expressed with a finite lexical notation.

3914. The system of aspect 3912 further including means for causing the system to represent numeric data types are non-enumerated data types and express numeric data elements of the numeric data types using equalities and/or inequalities.

3915. The system of aspect 3902 further including means for causing the one or more system to represent the data types as enumerable and non-enumerable data types.

3916. The system of aspect 3902 further including means for representing all data elements of the non-enumerated data types as sets.

3917. The system of aspect 3916 wherein all data elements consisting of infinite sets are expressed with a finite lexical notation when executed on the system.

3918. The system of aspect 3916 including means for causing the system to represent numeric data types are non-enumerated data types and express numeric data elements of the numeric data types using equalities and/or inequalities.

3919. The system of aspect 3900 wherein said means for verifying decidable and complete data flow include means for verifying both a code path quality and a data flow quality of the language.

3920. The system of aspect 3919 wherein said means for verifying a code path quality include means for demonstrating all possible code paths within the language can be expressed in a finite tree model.

3921. The system of aspect 3920, wherein the tree model comprises a directed acyclic graph.

3922. The system of aspect 3920, wherein said means for demonstrating all possible code paths within the language include means for generating a tree model using a tableau algorithm.

3923. The system of aspect 3920, wherein said means for demonstrating all possible code paths within the language include means for generating a tree model using a model search algorithm.

3924. The system of aspect 3919, wherein means for verifying the data flow quality further include means for identifying a set of one or more complete and correct algorithms that can determine the value of any data element in the set of all programs written in the language.

3925. The system of aspect 3924 wherein means for identifying a set of one or more complete and correct algorithms include means for demonstrating a valid algorithm for each data type associated with the language.

3926. The system of aspect 3925, wherein means for demonstrating a valid algorithm for each data type include means for utilizing automated algebraic analysis.

3927. The system of aspect 3925, wherein means for demonstrating a valid algorithm for each data type include means for utilizing approximation.

3928. The system of aspect 3900, further including means that when executed on the system cause the systems to: repeat said designing the language after said verifying the decidable and complete data flow if decidable and complete data flow is unverifiable.

3929. The system of aspect 3857, wherein the means for the operations of designing and verifying are executed by the system repeatedly until decidable and complete data flow is verified.

3930. The system of aspect 3851 wherein means for employing a finite input/output semantic model include means for generating a software procedure and a corresponding FIOSM for the software procedure.

3931. The system of aspect 3851 wherein means for employing a finite input/output semantic model include means for generating a software routine and a corresponding FIOSM for the software routine.

3932. The system of aspect 3851 wherein means for employing a finite input/output semantic model include means for generating a software program and a corresponding FIOSM for the software program.

3933. The system of aspect 3851 wherein means for employing a finite input/output semantic model include means for generating a software module and a corresponding FIOSM for the software module.

3934. The system of aspect 3851 wherein means for employing a finite input/output semantic model include means for generating a software enterprise system and a corresponding FIOSM for the software enterprise system.

3935. A system comprising:
a means for receiving a source program;
a means for parsing the source program into an abstract data structure;
a means for generating a set of code paths based on the abstract data structure;
a means for converting the set of code paths into a set of logically consistent data element models;
a means for utilizing the set of logically consistent data element models to format the finite input/output semantic model including:
   a means for identifying a set of input data elements in the source program,
   a means for identifying a set of output data elements in the source program, and for each set of data elements, creating an input-output pattern expression;
   a means for producing a valid data expression for each set of input data elements; and
   a means for producing a valid data expression for each set of output data elements.

3936. The system of aspect 3935 wherein the abstract data structure comprises a parse tree.

3937. The system of aspect 3935 wherein the abstract data structure comprises a tree model

3938. The system of aspect 3935 wherein the abstract data structure comprises a directed acyclic graph structure.

3939. The system of aspect 3936 wherein means for generating a set of code paths based on the abstract data structure include means for walking the parse tree.

3940. The system of aspect 3936 wherein means for generating a set of code paths based on the abstract data structure include means for using a suitable algorithm to walk the parse tree.

3941. The system of aspect 3940 wherein the suitable algorithm is a model-splitting type algorithm.

3942. The system of aspect 3941 wherein the model-splitting type algorithm is a member of the Tableau family of algorithms.

3943. The system of aspect 3940 wherein the suitable algorithm is a book-marking type algorithm.

3944. The system of aspect 3940 wherein the suitable algorithm is a model search algorithm.

3945. The system of aspect 3935 wherein each data element model of the set of logically consistent data element models represents one input-output pattern of the source program.

3946. The system of aspect 3935, wherein means for converting the set of code paths into a set of logically consistent data element models include means for discarding logically inconsistent data element models from the set of code paths.

3947. The system of aspect 3935, wherein means for converting the set of code paths into a set of logically consistent data element models include means for (i) walking the set of code paths, (ii) generating the set of data element models, and (iii) testing each data element model of the set for data-element consistency.

3948. A system comprising:
a means for specifying a known programming language; and
a means for modifying the language wherein any program written in the language is finite input output semantic model compliant.

3949. The system of aspect 3948 wherein the known programming language comprises one of: C, C+, C++, Java, Basic, Pascal, and Fortran.

3950. The system of aspect 3948, wherein means for modifying language include means for removing all operators (i) having ambiguous semantics and (ii) being capable of invoking infinite code paths.

3951. The system of aspect 3949, wherein means for modifying language include means for removing all operators (i) having ambiguous semantics and (ii) being capable of invoking infinite code paths.

3952. The system of aspect 3948, wherein means for modifying an existing software programming language include means for removing all operators capable of invoking infinite code paths.

3953. The system of aspect 3949, wherein means for modifying an existing software programming language include means for removing all operators capable of invoking infinite code paths.

3954. The system of aspect 3950 further including a means for replacing the removed operators with one or more alternative operators incapable of invoking infinite loops.

3955. The system of aspect 3951 including a means for replacing the removed operators with one or more alternative operators incapable of invoking infinite loops.

3956. The system of aspect 3952 including a means for replacing the removed operators with one or more alternative operators incapable of invoking infinite loops.

3957. The system of aspect 3953 including a means for replacing the removed operators with one or more alternative operators incapable of invoking infinite loops.

3958. The system of aspect 3950 including a means for replacing the removed operators with one or more alternative operators having unambiguous semantics.

3959. The system of aspect 3951 including a means for replacing the removed operators with one or more alternative operators having unambiguous semantics.

3960. The system of aspect 3952 including a means for replacing the removed operators with one or more alternative operators having unambiguous semantics.

3961. The system of aspect 3953 including a means for replacing the removed operators with one or more alternative operators having unambiguous semantics.

3962. The system of aspect 3950 including a means for replacing a for loop operator with “sum” operator.

3963. The system of aspect 3951 including a means for replacing a for loop operator with “sum” operator.

3964. The system of aspect 3952 including a means for replacing a for loop operator with “sum” operator.

3965. The system of aspect 3953 including a means for replacing a for loop operator with “sum” operator.

3966. The system of aspect 3954 including a means for replacing a for loop operator with “sum” operator.

3967. The system of aspect 3955 including a means for replacing a for loop operator with “sum” operator.

3968. The system of aspect 3956 including a means for replacing a for loop operator with “sum” operator.

3969. The system of aspect 3957 including a means for replacing a for loop operator with “sum” operator.

3970. The system of aspect 3958 including a means for replacing a for loop operator with “sum” operator.

3971. The system of aspect 3959 including a means for replacing a for loop operator with “sum” operator.

3972. The system of aspect 3960 including a means for replacing a for loop operator with “sum” operator.

3973. The system of aspect 3961 including a means for replacing a for loop operator with “sum” operator.

3974. The system of aspect 3948, wherein means for modifying the language include means for redefining one or more data types.

3975. The system of aspect 3948, wherein means for modifying the language include means for replacing one or more data types.

3976. The system of aspect 3949, wherein means for modifying the language include means for redefining one or more data types.

3977. The system of aspect 3949, wherein means for modifying the language include means for replacing one or more data types.

3978. The system of aspect 3950, wherein means for modifying the language include means for redefining one or more data types.

3979. The system of aspect 3950, wherein means for modifying the language include means for replacing one or more data types.

3980. The system of aspect 3951, wherein means for modifying the language include means for redefining one or more data types.

3981. The system of aspect 3951, wherein means for modifying the language include means for replacing one or more data types.

3982. The system of aspect 3952, wherein means for modifying the language include means for redefining one or more data types.

3983. The system of aspect 3952, wherein means for modifying the language include means for replacing one or more data types.

3984. The system of aspect 3953, wherein means for modifying the language include means for redefining one or more data types.

3985. The system of aspect 3953, wherein means for modifying the language include means for replacing one or more data types.

3986. The system of aspect 3954, wherein means for modifying the language include means for redefining one or more data types.

3987. The system of aspect 3954, wherein means for modifying the language include means for replacing one or more data types.

3988. The system of aspect 3955, wherein means for modifying the language include means for redefining one or more data types.

3989. The system of aspect 3955, wherein means for modifying the language include means for replacing one or more data types.

3990. The system of aspect 3956, wherein means for modifying the language include means for redefining one or more data types.

3991. The system of aspect 3956, wherein means for modifying the language include means for replacing one or more data types.

3992. The system of aspect 3957, wherein means for modifying the language include means for redefining one or more data types.

3993. The system of aspect 3957, wherein means for modifying the language include means for replacing one or more data types.

3994. The system of aspect 3958, wherein means for modifying the language include means for redefining one or more data types.

3995. The system of aspect 3958, wherein means for modifying the language include means for replacing one or more data types.

3996. The system of aspect 3959, wherein means for modifying the language include means for redefining one or more data types.

3997. The system of aspect 3959, wherein means for modifying the language include means for replacing one or more data types.

3998. The system of aspect 3960, wherein means for modifying the language include means for redefining one or more data types.

3999. The system of aspect 3960, wherein means for modifying the language include means for replacing one or more data types.

4000. The system of aspect 3961, wherein means for modifying the language include means for redefining one or more data types.

4001. The system of aspect 3961, wherein means for modifying the language include means for replacing one or more data types.

4002. The system of aspect 3962, wherein means for modifying the language include means for redefining one or more data types.

4003. The system of aspect 3962, wherein means for modifying the language include means for replacing one or more data types.

4004. The system of aspect 3963, wherein means for modifying the language include means for redefining one or more data types.

4005. The system of aspect 3963, wherein means for modifying the language include means for replacing one or more data types.

4006. The system of aspect 3964, wherein means for modifying the language include means for redefining one or more data types.

4007. The system of aspect 3964, wherein means for modifying the language include means for replacing one or more data types.

4008. The system of aspect 3965, wherein means for modifying the language include means for redefining one or more data types.

4009. The system of aspect 3965, wherein means for modifying the language include means for replacing one or more data types.

4010. The system of aspect 3966, wherein means for modifying the language include means for redefining one or more data types.

4011. The system of aspect 3966, wherein means for modifying the language include means for replacing one or more data types.

4012. The system of aspect 3967, wherein means for modifying the language include means for redefining one or more data types.

4013. The system of aspect 3967, wherein means for modifying the language include means for replacing one or more data types.

4014. The system of aspect 3968, wherein means for modifying the language include means for redefining one or more data types.

4015. The system of aspect 3968, wherein means for modifying the language include means for replacing one or more data types.

4016. The system of aspect 3969, wherein means for modifying the language include means for redefining one or more data types.

4017. The system of aspect 3969, wherein means for modifying the language include means for replacing one or more data types.

4018. The system of aspect 3970, wherein means for modifying the language include means for redefining one or more data types.

4019. The system of aspect 3970, wherein means for modifying the language include means for replacing one or more data types.

4020. The system of aspect 3971, wherein means for modifying the language include means for redefining one or more data types.

4021. The system of aspect 3971, wherein means for modifying the language include means for replacing one or more data types.

4022. The system of aspect 3972, wherein means for modifying the language include means for redefining one or more data types.

4023. The system of aspect 3972, wherein means for modifying the language include means for replacing one or more data types.

4024. The system of aspect 3973, wherein means for modifying the language include means for redefining one or more data types.

4025. The system of aspect 3973, wherein means for modifying the language include means for replacing one or more data types.

4026. The system of aspect 3948 further comprising means for verifying that all programs created in the language have decidable and complete data flow.

4027. A system comprising:
means for specifying a known programming language; and
means for modifying the language wherein the modified language satisfies both a finite code path property and a data flow property.

4028. The system of aspect 4027 further comprising means for verifying compliance with the finite code path property.

4029. The system of aspect 4027 further comprising means for verifying compliance with the data flow property.

4030. The system of aspect 4028 further comprising means for verifying compliance with the data flow property.

4031. The system of aspect 4027 wherein said means for modifying the language includes means for redefining one or more data types.

4032. The system of aspect 4028 wherein said means for modifying the language includes means for redefining one or more data types.

4033. The system of aspect 4029 wherein said means for modifying the language includes means for redefining one or more data types.

4034. The system of aspect 4030 wherein said means for modifying the language includes means for redefining one or more data types.

4035. The system of aspect 4027 wherein said means for modifying the language includes means for replacing one or more operators having ambiguous semantics with replacement operators having unambiguous semantics.

4036. The system of aspect 4028 wherein said means for modifying the language includes means for replacing one or more operators having ambiguous semantics with replacement operators having unambiguous semantics.

4037. The system of aspect 4029 wherein said means for modifying the language includes means for replacing one or more operators having ambiguous semantics with replacement operators having unambiguous semantics.

4038. The system of aspect 4030 wherein said means for modifying the language includes means for replacing one or more operators having ambiguous semantics with replacement operators having unambiguous semantics.

4039. The system of aspect 4031 wherein said means for modifying the language includes means for replacing one or more operators having ambiguous semantics with replacement operators having unambiguous semantics.

4040. The system of aspect 4032 wherein said means for modifying the language includes means for replacing one or more operators having ambiguous semantics with replacement operators having unambiguous semantics.

4041. The system of aspect 4033 wherein said means for modifying the language includes means for replacing one or more operators having ambiguous semantics with replacement operators having unambiguous semantics.

4042. The system of aspect 4034 wherein said means for modifying the language includes means for replacing one or more operators having ambiguous semantics with replacement operators having unambiguous semantics.

4043. The system of aspect 4031 wherein the redefined data types comprise enumerable and non-enumerable data types.

4044. The system of aspect 4032 wherein the redefined data types comprise enumerable and non-enumerable data types.

4045. The system of aspect 4033 wherein the redefined data types comprise enumerable and non-enumerable data types.

4046. The system of aspect 4034 wherein the redefined data types comprise enumerable and non-enumerable data types.

4047. The system of aspect 4031 wherein the redefined data types comprise enumerable and non-enumerable data types.

4048. The system of aspect 4043 wherein all data elements of the non-enumerated data types are represented as sets.

4049. The system of aspect 4044 wherein all data elements of the non-enumerated data types are represented as sets.

4050. The system of aspect 4045 wherein all data elements of the non-enumerated data types are represented as sets.

4051. The system of aspect 4046 wherein all data elements of the non-enumerated data types are represented as sets.

4052. The system of aspect 4047 wherein all data elements of the non-enumerated data types are represented as sets.

4053. The system of aspect 4048 wherein all data elements consisting of infinite sets are expressed with a finite lexical notation.

4054. The system of aspect 4049 wherein all data elements consisting of infinite sets are expressed with a finite lexical notation.

4055. The system of aspect 4050 wherein all data elements consisting of infinite sets are expressed with a finite lexical notation.

4056. The system of aspect 4051 wherein all data elements consisting of infinite sets are expressed with a finite lexical notation.

4057. The system of aspect 4052 wherein all data elements consisting of infinite sets are expressed with a finite lexical notation.

4058. The system of aspect 4048 wherein numeric data types are non-enumerated data types and numeric data elements of the numeric data types are expressed using equalities and/or inequalities.

4059. The system of aspect 4049 wherein numeric data types are non-enumerated data types and numeric data elements of the numeric data types are expressed using equalities and/or inequalities.

4060. The system of aspect 4050 wherein numeric data types are non-enumerated data types and numeric data elements of the numeric data types are expressed using equalities and/or inequalities.

4061. The system of aspect 4051 wherein numeric data types are non-enumerated data types and numeric data elements of the numeric data types are expressed using equalities and/or inequalities.

4062. The system of aspect 4052 wherein numeric data types are non-enumerated data types and numeric data elements of the numeric data types are expressed using equalities and/or inequalities.

4063. The system of aspect 4028 wherein said means for verifying compliance with the finite code path property includes means for demonstrating all possible code paths within the language can be expressed in a finite tree model.

4064. The system of aspect 4063, wherein the tree model comprises a directed acyclic graph.

4065. The system of aspect 4064 wherein said means for demonstrating all possible code paths within the language includes means for generating a tree model using a tableau algorithm.

4066. The system of aspect 4063 wherein said means for demonstrating all possible code paths within the language includes means for generating a tree model using a tableau algorithm.

4067. The system of aspect 4063 wherein said demonstrating all possible code paths within the language includes generating a tree model using a model search algorithm.

4068. The system of aspect 4029 wherein said means for verifying compliance with the finite code path property includes means for demonstrating all possible code paths within the language can be expressed in a finite tree model.

4069. The system of aspect 4068, wherein the tree model comprises a directed acyclic graph.

4070. The system of aspect 4069 wherein said means for demonstrating all possible code paths within the language includes means for generating a tree model using a tableau algorithm.

4071. The system of aspect 4041 wherein said means for demonstrating all possible code paths within the language includes means for generating a tree model using a tableau algorithm.

4072. The system of aspect 4041 wherein said means for demonstrating all possible code paths within the language includes means for generating a tree model using a model search algorithm.

4073. The system of aspect 4030 wherein said means for verifying compliance with the finite code path property includes means for demonstrating all possible code paths within the language can be expressed in a finite tree model.

4074. The system of aspect 4073, wherein the tree model comprises a directed acyclic graph.

4075. The system of aspect 4074 wherein said means for demonstrating all possible code paths within the language includes means for generating a tree model using a tableau algorithm.

4076. The system of aspect 4073 wherein said means for demonstrating all possible code paths within the language includes means for generating a tree model using a tableau algorithm.

4077. The system of aspect 4073 wherein said means for demonstrating all possible code paths within the language includes means for generating a tree model using a model search algorithm.

4078. The system of aspect 4029, wherein said means for verifying compliance with the data flow property includes means for identifying a set of one or more complete and correct algorithms that can determine the value of any data element in the set of all programs written in the language.

4079. The system of aspect 4078 wherein said means for identifying a set of one or more complete and correct algorithms includes means for demonstrating a valid algorithm for each data type associated with the language.

4080. The system of aspect 4079, wherein said means for demonstrating a valid algorithm for each data type includes means for utilizing automated algebraic analysis.

4081. The system of aspect 4079, wherein said means for demonstrating a valid algorithm for each data type includes means for utilizing approximation.

4082. The system of aspect 4033, wherein said means for verifying compliance with the data flow property includes means for identifying a set of one or more complete and correct algorithms that can determine the value of any data element in the set of all programs written in the language.

4083. The system of aspect 4082 wherein said means for identifying a set of one or more complete and correct algorithms includes means for demonstrating a valid algorithm for each data type associated with the language.

4084. The system of aspect 4083, wherein said means for demonstrating a valid algorithm for each data type includes means for utilizing automated algebraic analysis.

4085. The system of aspect 4083, wherein said means for demonstrating a valid algorithm for each data type includes means for utilizing approximation.

4086. The system of aspect 4037, wherein said means for verifying compliance with the data flow property includes means for identifying a set of one or more complete and correct algorithms that can determine the value of any data element in the set of all programs written in the language.

4087. The system of aspect 4086 wherein said means for identifying a set of one or more complete and correct algorithms includes means for demonstrating a valid algorithm for each data type associated with the language.

4088. The system of aspect 4087, wherein said means for demonstrating a valid algorithm for each data type includes means for utilizing automated algebraic analysis.

4089. The system of aspect 4087, wherein said means for demonstrating a valid algorithm for each data type includes means for utilizing approximation.

4090. A means for employing a finite input/output semantic model (FIOSM).

4091. A means for modifying the language wherein any program written in the language is finite input output semantic model compliant.

4092. A means for modifying the language wherein the modified language satisfies both a finite code path property and a data flow property.

4093. A system for creating a computer language wherein a set of all programs created in the language have a decidable and complete data flow, the system comprising:
means for designing the language including defining operators and defining data types; and
means for verifying the decidable and complete data flow.

4094. A system comprising:
means for designing the language including defining operators and defining data types; and
means for verifying an FIOSM can be generated for all programs created in the language by verifying all programs have decidable and complete data flow.

4095. A system comprising:
means for designing a software language including defining a set of all operators and defining a set of data types; and
means for verifying that each operator of the set of operators is incapable of invoking an infinite loop.

4096. A method of creating the computer language wherein each operator of a set consisting of all operators in the language is incapable of invoking an infinite code path, the method comprising:
designing the language including defining the set of all operators and defining a set of data types; and
verifying that each operator of the set of operators is incapable of invoking an infinite loop.

4097. A system comprising:
means for creating a finite input output semantic model (FIOSM) compliant programming language;
means for generating a software program in the FIOSM compliant language; and
   means for generating a FIOSM for the program.

4098. A system comprising:
means for creating a finite input output semantic model (FIOSM) compliant programming language;
means for generating a software procedure in the FIOSM compliant language; and
means for generating a FIOSM for the procedure.

4099. A system comprising:
means for creating a finite input output semantic model (FIOSM) compliant programming language;
means for generating a software routine in the FIOSM compliant language; and
means for generating a FIOSM for the routine.

4100. A system comprising:
means for creating a finite input output semantic model (FIOSM) compliant programming language;
means for generating a software enterprise system in the FIOSM compliant language; and
means for generating a FIOSM for the enterprise system.

4101. A system comprising:
means for designing a programming language;
means for defining a finite input output semantic model for the programming language; and
means for verifying code path and data flow qualities of the programming language.

4102. A system comprising means for representing a software program having fully decidable data flow in a parse tree.

4103. A system comprising means for representing a software procedure having fully decidable data flow in a parse tree.

4104. A system comprising means for representing a software routine having fully decidable data flow in a parse tree.

4105. A system comprising means for representing a software module having fully decidable data flow in a parse tree.

4106. A system comprising means for representing a software enterprise system having fully decidable data flow in a parse tree.

4107. A system comprising:
means for generating a finite input/output semantic model for a software procedure; and
means for using the model for ensuring quality of the software procedure.

4108. A means of automating software quality control utilizing a finite input/output semantic model.

4109. A means of automating software quality control based on a finite input/output semantic model of the software.

4110. A software module governed by a finite input/output semantic (FIOSM) model.

4111. The software module of aspect 4110, wherein the software module does not include operators having ambiguous semantics or operators capable of invoking infinite code paths.

4112. The software module of aspect 4111, wherein the infinite code paths comprise infinite loops.

4113. The software module of aspect 4110, further including a plurality of operators wherein not one of the plurality of operators is capable of invoking an infinite code path in the software module.

4114. The software module of aspect 4113, wherein the infinite code path comprises an infinite loop.

4115. The software module of aspect 4110, further including a plurality of operators wherein no combination of operators of the plurality of operators are capable of invoking an infinite code path in the software module.

4116. The software module of aspect 4115, wherein the infinite code path comprises an infinite loop.

4117. The software module of aspect 4110, wherein the software module is a written in a modified version of a preexisting computer language, the modified version having a decidable and complete data flow.

4118. The software module of aspect 4117 wherein the existing computer language is one of C, C+, C++, Java, Basic, Pascal, and Fortran.

4119. The software module of aspect 4110 wherein the software module is written in a computer language wherein each operator of a set consisting of all operators in the computer language has unambiguous semantics and is incapable of an invoking infinite code path alone or in combination with other operators.

4120. The software module of aspect 4110 wherein the software module is written in a computer language wherein all modules created in the language have a decidable and complete data flow.

4121. The software module of aspect 4110 wherein the software module is written in a computer language wherein a finite input output semantic model can be generated for any software module created in the language.

4122. The software module of aspect 4110 wherein the software module is written in a computer language wherein the software module is written in a computer language wherein each operator of a set consisting of all operators in the computer language is incapable of an invoking infinite code path alone or in combination with other operators.

4123. The software module of aspect 4110, comprising at least 1,000 lines of code.

4124. The software module of aspect 4111, comprising at least 1,000 lines of code.

4125. The software module of aspect 4112, comprising at least 1,000 lines of code.

4126. The software module of aspect 4113, comprising at least 1,000 lines of code.

4127. The software module of aspect 4114, comprising at least 1,000 lines of code.

4128. The software module of aspect 4115, comprising at least 1,000 lines of code.

4129. The software module of aspect 4116, comprising at least 1,000 lines of code.

4130. The software module of aspect 4117, comprising at least 1,000 lines of code.

4131. The software module of aspect 4118, comprising at least 1,000 lines of code.

4132. The software module of aspect 4119, comprising at least 1,000 lines of code.

4133. The software module of aspect 4120, comprising at least 1,000 lines of code.

4134. The software module of aspect 4121, comprising at least 1,000 lines of code.

4135. The software module of aspect 4122, comprising at least 1,000 lines of code.

4136. The software module of aspect 4110, comprising at least 10,000 lines of code.

4137. The software module of aspect 4111, comprising at least 10,000 lines of code.

4138. The software module of aspect 4112, comprising at least 10,000 lines of code.

4139. The software module of aspect 4113, comprising at least 10,000 lines of code.

4140. The software module of aspect 4114, comprising at least 10,000 lines of code.

4141. The software module of aspect 4115, comprising at least 10,000 lines of code.

4142. The software module of aspect 4116, comprising at least 10,000 lines of code.

4143. The software module of aspect 4117, comprising at least 10,000 lines of code.

4144. The software module of aspect 4118, comprising at least 10,000 lines of code.

4145. The software module of aspect 4119, comprising at least 10,000 lines of code.

4146. The software module of aspect 4120, comprising at least 10,000 lines of code.

4147. The software module of aspect 4121, comprising at least 10,000 lines of code.

4148. The software module of aspect 4122, comprising at least 10,000 lines of code.

4149. The software module of aspect 4110, comprising at least 100,000 lines of code.

4150. The software module of aspect 4111, comprising at least 100,000 lines of code.

4151. The software module of aspect 4112, comprising at least 100,000 lines of code.

4152. The software module of aspect 4113, comprising at least 100,000 lines of code.

4153. The software module of aspect 4114, comprising at least 100,000 lines of code.

4154. The software module of aspect 4115, comprising at least 100,000 lines of code.

4155. The software module of aspect 4116, comprising at least 100,000 lines of code.

4156. The software module of aspect 4117, comprising at least 100,000 lines of code.

4157. The software module of aspect 4118, comprising at least 100,000 lines of code.

4158. The software module of aspect 4119, comprising at least 100,000 lines of code.

4159. The software module of aspect 4120, comprising at least 100,000 lines of code.

4160. The software module of aspect 4121, comprising at least 100,000 lines of code.

4161. The software module of aspect 4122, comprising at least 100,000 lines of code.

4162. The software module of aspect 4110, comprising at least 1,000,000 lines of code.

4163. The software module of aspect 4111, comprising at least 1,000,000 lines of code.

4164. The software module of aspect 4112, comprising at least 1,000,000 lines of code.

4165. The software module of aspect 4113, comprising at least 1,000,000 lines of code.

4166. The software module of aspect 4114, comprising at least 1,000,000 lines of code.

4167. The software module of aspect 4115, comprising at least 1,000,000 lines of code.

4168. The software module of aspect 4116, comprising at least 1,000,000 lines of code.

4169. The software module of aspect 4117, comprising at least 1,000,000 lines of code.

4170. The software module of aspect 4118, comprising at least 1,000,000 lines of code.

4171. The software module of aspect 4119, comprising at least 1,000,000 lines of code.

4172. The software module of aspect 4120, comprising at least 1,000,000 lines of code.

4173. The software module of aspect 4121, comprising at least 1,000,000 lines of code.

4174. The software module of aspect 4122, comprising at least 1,000,000 lines of code.

4175. A software module wherein all outputs can be mapped to all inputs.

4176. The software module of aspect 4175, wherein the software module does not include operators having ambiguous semantics or operators capable of invoking infinite code paths.

4177. The software module of aspect 4176, wherein the infinite code paths comprise infinite loops.

4178. The software module of aspect 4175, further including a plurality of operators wherein not one of the plurality of operators is capable of invoking an infinite code path in the software module.

4179. The software module of aspect 4178, wherein the infinite code path comprises an infinite loop.

4180. The software module of aspect 4175, further including a plurality of operators wherein no combination of operators of the plurality of operators are capable of invoking an infinite code path in the software module.

4181. The software module of aspect 4180, wherein the infinite code path comprises an infinite loop.

4182. The software module of aspect 4175, wherein the software module is a written in a modified version of an existing computer language.

4183. The software module of aspect 4182 wherein the existing computer language is one of C, C+, C++, Java, Basic, Pascal, and Fortran.

4184. The software module of aspect 4175 wherein the software module is written in a computer language wherein each operator of a set consisting of all operators in the computer language has unambiguous semantics and is incapable of an invoking infinite code path alone or in combination with other operators.

4185. The software module of aspect 4175 wherein the software module is written in a computer language wherein all modules created in the language have a decidable and complete data flow.

4186. The software module of aspect 4175 wherein the software module is written in a computer language wherein a finite input output semantic model can be generated for any module created in the language.

4187. The software module of aspect 4175 wherein the software module is written in a computer language wherein the software module is written in a computer language wherein each operator of a set consisting of all operators in the computer language is incapable of an invoking infinite code path alone or in combination with other operators.

4188. The software module of aspect 4175, comprising at least 1,000 lines of code.

4189. The software module of aspect 4176, comprising at least 1,000 lines of code.

4190. The software module of aspect 4177, comprising at least 1,000 lines of code.

4191. The software module of aspect 4178, comprising at least 1,000 lines of code.

4192. The software module of aspect 4179, comprising at least 1,000 lines of code.

4193. The software module of aspect 4180, comprising at least 1,000 lines of code.

4194. The software module of aspect 4181, comprising at least 1,000 lines of code.

4195. The software module of aspect 4182, comprising at least 1,000 lines of code.

4196. The software module of aspect 4183, comprising at least 1,000 lines of code.

4197. The software module of aspect 4184, comprising at least 1,000 lines of code.

4198. The software module of aspect 4185, comprising at least 1,000 lines of code.

4199. The software module of aspect 4186, comprising at least 1,000 lines of code.

4200. The software module of aspect 4187, comprising at least 1,000 lines of code.

4201. The software module of aspect 4175, comprising at least 10,000 lines of code.

4202. The software module of aspect 4176, comprising at least 10,000 lines of code.

4203. The software module of aspect 4177, comprising at least 10,000 lines of code.

4204. The software module of aspect 4178, comprising at least 10,000 lines of code.

4205. The software module of aspect 4179, comprising at least 10,000 lines of code.

4206. The software module of aspect 4180, comprising at least 10,000 lines of code.

4207. The software module of aspect 4181, comprising at least 10,000 lines of code.

4208. The software module of aspect 4182, comprising at least 10,000 lines of code.

4209. The software module of aspect 4183, comprising at least 10,000 lines of code.

4210. The software module of aspect 4184, comprising at least 10,000 lines of code.

4211. The software module of aspect 4185, comprising at least 10,000 lines of code.

4212. The software module of aspect 4186, comprising at least 10,000 lines of code.

4213. The software module of aspect 4187, comprising at least 10,000 lines of code.

4214. The software module of aspect 4175, comprising at least 100,000 lines of code.

4215. The software module of aspect 4176, comprising at least 100,000 lines of code.

4216. The software module of aspect 4177, comprising at least 100,000 lines of code.

4217. The software module of aspect 4178, comprising at least 100,000 lines of code.

4218. The software module of aspect 4179, comprising at least 100,000 lines of code.

4219. The software module of aspect 4180, comprising at least 100,000 lines of code.

4220. The software module of aspect 4181, comprising at least 100,000 lines of code.

4221. The software module of aspect 4182, comprising at least 100,000 lines of code.

4222. The software module of aspect 4183, comprising at least 100,000 lines of code.

4223. The software module of aspect 4184, comprising at least 100,000 lines of code.

4224. The software module of aspect 4185, comprising at least 100,000 lines of code.

4225. The software module of aspect 4186, comprising at least 100,000 lines of code.

4226. The software module of aspect 4187, comprising at least 100,000 lines of code.

4227. The software module of aspect 4175, comprising at least 1,000,000 lines of code.

4228. The software module of aspect 4176, comprising at least 1,000,000 lines of code.

4229. The software module of aspect 4177, comprising at least 1,000,000 lines of code.

4230. The software module of aspect 4178, comprising at least 1,000,000 lines of code.

4231. The software module of aspect 4179, comprising at least 1,000,000 lines of code.

4232. The software module of aspect 4180, comprising at least 1,000,000 lines of code.

4233. The software module of aspect 4181, comprising at least 1,000,000 lines of code.

4234. The software module of aspect 4182, comprising at least 1,000,000 lines of code.

4235. The software module of aspect 4183, comprising at least 1,000,000 lines of code.

4236. The software module of aspect 4184, comprising at least 1,000,000 lines of code.

4237. The software module of aspect 4185, comprising at least 1,000,000 lines of code.

4238. The software module of aspect 4186, comprising at least 1,000,000 lines of code.

4239. The software module of aspect 4187, comprising at least 1,000,000 lines of code.

4240. A software module having a finite set of input and output patterns.

4241. The software module of aspect 4240, wherein the software module does not include operators having ambiguous semantics or operators capable of invoking infinite code paths.

4242. The software module of aspect 4241, wherein the infinite code paths comprise infinite loops.

4243. The software module of aspect 4240, further including a plurality of operators wherein not one of the plurality of operators is capable of invoking an infinite code path in the software module.

4244. The software module of aspect 4243, wherein the infinite code path comprises an infinite loop.

4245. The software module of aspect 4240, further including a plurality of operators wherein no combination of operators of the plurality of operators are capable of invoking an infinite code path in the software module.

4246. The software module of aspect 4245, wherein the infinite code path comprises an infinite loop.

4247. The software module of aspect 4240, wherein the software module is a written in a modified version of an existing computer language.

4248. The software module of aspect 4247 wherein the existing computer language is one of C, C+, C++, Java, Basic, Pascal, and Fortran.

4249. The software module of aspect 4240 wherein the software module is written in a computer language wherein each operator of a set consisting of all operators in the computer language has unambiguous semantics and is incapable of an invoking infinite code path alone or in combination with other operators.

4250. The software module of aspect 4240 wherein the software module is written in a computer language wherein all modules created in the language have a decidable and complete data flow.

4251. The software module of aspect 4240 wherein the software module is written in a computer language wherein a finite input output semantic model can be generated for any module created in the language.

4252. The software module of aspect 4240 wherein the software module is written in a computer language wherein the software module is written in a computer language wherein each operator of a set consisting of all operators in the computer language is incapable of an invoking infinite code path alone or in combination with other operators.

4253. The software module of aspect 4240, comprising at least 1,000 lines of code.

4254. The software module of aspect 4241, comprising at least 1,000 lines of code.

4255. The software module of aspect 4242, comprising at least 1,000 lines of code.

4256. The software module of aspect 4243, comprising at least 1,000 lines of code.

4257. The software module of aspect 4244, comprising at least 1,000 lines of code.

4258. The software module of aspect 4245, comprising at least 1,000 lines of code.

4259. The software module of aspect 4246, comprising at least 1,000 lines of code.

4260. The software module of aspect 4247, comprising at least 1,000 lines of code.

4261. The software module of aspect 4248, comprising at least 1,000 lines of code.

4262. The software module of aspect 4249, comprising at least 1,000 lines of code.

4263. The software module of aspect 4250, comprising at least 1,000 lines of code.

4264. The software module of aspect 4251, comprising at least 1,000 lines of code.

4265. The software module of aspect 4252, comprising at least 1,000 lines of code.

4266. The software module of aspect 4240, comprising at least 10,000 lines of code.

4267. The software module of aspect 4241, comprising at least 10,000 lines of code.

4268. The software module of aspect 4242, comprising at least 10,000 lines of code.

4269. The software module of aspect 4243, comprising at least 10,000 lines of code.

4270. The software module of aspect 4244, comprising at least 10,000 lines of code.

4271. The software module of aspect 4245, comprising at least 10,000 lines of code.

4272. The software module of aspect 4246, comprising at least 10,000 lines of code.

4273. The software module of aspect 4247, comprising at least 10,000 lines of code.

4274. The software module of aspect 4248, comprising at least 10,000 lines of code.

4275. The software module of aspect 4249, comprising at least 10,000 lines of code.

4276. The software module of aspect 4250, comprising at least 10,000 lines of code.

4277. The software module of aspect 4251, comprising at least 10,000 lines of code.

4278. The software module of aspect 4252, comprising at least 10,000 lines of code.

4279. The software module of aspect 4240, comprising at least 100,000 lines of code.

4280. The software module of aspect 4241, comprising at least 100,000 lines of code.

4281. The software module of aspect 4242, comprising at least 100,000 lines of code.

4282. The software module of aspect 4243, comprising at least 100,000 lines of code.

4283. The software module of aspect 4244, comprising at least 100,000 lines of code.

4284. The software module of aspect 4245, comprising at least 100,000 lines of code.

4285. The software module of aspect 4246, comprising at least 100,000 lines of code.

4286. The software module of aspect 4247, comprising at least 100,000 lines of code.

4287. The software module of aspect 4248, comprising at least 100,000 lines of code.

4288. The software module of aspect 4249, comprising at least 100,000 lines of code.

4289. The software module of aspect 4250, comprising at least 100,000 lines of code.

4290. The software module of aspect 4251, comprising at least 100,000 lines of code.

4291. The software module of aspect 4252, comprising at least 100,000 lines of code.

4292. The software module of aspect 4240, comprising at least 1,000,000 lines of code.

4293. The software module of aspect 4241, comprising at least 1,000,000 lines of code.

4294. The software module of aspect 4242, comprising at least 1,000,000 lines of code.

4295. The software module of aspect 4243, comprising at least 1,000,000 lines of code.

4296. The software module of aspect 4244, comprising at least 1,000,000 lines of code.

4297. The software module of aspect 4245, comprising at least 1,000,000 lines of code.

4298. The software module of aspect 4246, comprising at least 1,000,000 lines of code.

4299. The software module of aspect 4247, comprising at least 1,000,000 lines of code.

4300. The software module of aspect 4248, comprising at least 1,000,000 lines of code.

4301. The software module of aspect 4249, comprising at least 1,000,000 lines of code.

4302. The software module of aspect 4250, comprising at least 1,000,000 lines of code.

4303. The software module of aspect 4251, comprising at least 1,000,000 lines of code.

4304. The software module of aspect 4252, comprising at least 1,000,000 lines of code.

4305. A software module having completely decidable data flow.

4306. The software module of aspect 4305, wherein the software module does not include operators having ambiguous semantics or operators capable of invoking infinite code paths.

4307. The software module of aspect 4306, wherein the infinite code paths comprise infinite loops.

4308. The software module of aspect 4305, further including a plurality of operators wherein not one of the plurality of operators is capable of invoking an infinite code path in the software module.

4309. The software module of aspect 4308, wherein the infinite code path comprises an infinite loop.

4310. The software module of aspect 4305, further including a plurality of operators wherein no combination of operators of the plurality of operators are capable of invoking an infinite code path in the software module.

4311. The software module of aspect 4310, wherein the infinite code path comprises an infinite loop.

4312. The software module of aspect 4305, wherein the software module is a written in a modified version of an existing computer language.

4313. The software module of aspect 4312 wherein the existing computer language is one of C, C+, C++, Java, Basic, Pascal, and Fortran.

4314. The software module of aspect 4305 wherein the software module is written in a computer language wherein each operator of a set consisting of all operators in the computer language has unambiguous semantics and is incapable of an invoking infinite code path alone or in combination with other operators.

4315. The software module of aspect 4305 wherein the software module is written in a computer language wherein all modules created in the language have a decidable and complete data flow.

4316. The software module of aspect 4305 wherein the software module is written in a computer language wherein a finite input output semantic model can be generated for any module created in the language.

4317. The software module of aspect 4305 wherein the software module is written in a computer language wherein the software module is written in a computer language wherein each operator of a set consisting of all operators in the computer language is incapable of an invoking infinite code path alone or in combination with other operators.

4318. The software module of aspect 4305, comprising at least 1,000 lines of code.

4319. The software module of aspect 4306, comprising at least 1,000 lines of code.

4320. The software module of aspect 4307, comprising at least 1,000 lines of code.

4321. The software module of aspect 4308, comprising at least 1,000 lines of code.

4322. The software module of aspect 4309, comprising at least 1,000 lines of code.

4323. The software module of aspect 4310, comprising at least 1,000 lines of code.

4324. The software module of aspect 4311, comprising at least 1,000 lines of code.

4325. The software module of aspect 4312, comprising at least 1,000 lines of code.

4326. The software module of aspect 4313, comprising at least 1,000 lines of code.

4327. The software module of aspect 4314, comprising at least 1,000 lines of code.

4328. The software module of aspect 4315, comprising at least 1,000 lines of code.

4329. The software module of aspect 4316, comprising at least 1,000 lines of code.

4330. The software module of aspect 4317, comprising at least 1,000 lines of code.

4331. The software module of aspect 4305, comprising at least 10,000 lines of code.

4332. The software module of aspect 4306, comprising at least 10,000 lines of code.

4333. The software module of aspect 4307, comprising at least 10,000 lines of code.

4334. The software module of aspect 4308, comprising at least 10,000 lines of code.

4335. The software module of aspect 4309, comprising at least 10,000 lines of code.

4336. The software module of aspect 4310, comprising at least 10,000 lines of code.

4337. The software module of aspect 4311, comprising at least 10,000 lines of code.

4338. The software module of aspect 4312, comprising at least 10,000 lines of code.

4339. The software module of aspect 4313, comprising at least 10,000 lines of code.

4340. The software module of aspect 4314, comprising at least 10,000 lines of code.

4341. The software module of aspect 4315, comprising at least 10,000 lines of code.

4342. The software module of aspect 4316, comprising at least 10,000 lines of code.

4343. The software module of aspect 4317, comprising at least 10,000 lines of code.

4344. The software module of aspect 4305, comprising at least 100,000 lines of code.

4345. The software module of aspect 4306, comprising at least 100,000 lines of code.

4346. The software module of aspect 4307, comprising at least 100,000 lines of code.

4347. The software module of aspect 4308, comprising at least 100,000 lines of code.

4348. The software module of aspect 4309, comprising at least 100,000 lines of code.

4349. The software module of aspect 4310, comprising at least 100,000 lines of code.

4350. The software module of aspect 4311, comprising at least 100,000 lines of code.

4351. The software module of aspect 4312, comprising at least 100,000 lines of code.

4352. The software module of aspect 4313, comprising at least 100,000 lines of code.

4353. The software module of aspect 4314, comprising at least 100,000 lines of code.

4354. The software module of aspect 4315, comprising at least 100,000 lines of code.

4355. The software module of aspect 4316, comprising at least 100,000 lines of code.

4356. The software module of aspect 4317, comprising at least 100,000 lines of code.

4357. The software module of aspect 4305, comprising at least 1,000,000 lines of code.

4358. The software module of aspect 4306, comprising at least 1,000,000 lines of code.

4359. The software module of aspect 4307, comprising at least 1,000,000 lines of code.

4360. The software module of aspect 4308, comprising at least 1,000,000 lines of code.

4361. The software module of aspect 4309, comprising at least 1,000,000 lines of code.

4362. The software module of aspect 4310, comprising at least 1,000,000 lines of code.

4363. The software module of aspect 4311, comprising at least 1,000,000 lines of code.

4364. The software module of aspect 4312, comprising at least 1,000,000 lines of code.

4365. The software module of aspect 4313, comprising at least 1,000,000 lines of code.

4366. The software module of aspect 4314, comprising at least 1,000,000 lines of code.

4367. The software module of aspect 4315, comprising at least 1,000,000 lines of code.

4368. The software module of aspect 4316, comprising at least 1,000,000 lines of code.

4369. The software module of aspect 4317, comprising at least 1,000,000 lines of code.

4370. A software module embodying the finite code path property.

4371. The software module of aspect 4370, wherein the software module does not include operators having ambiguous semantics or operators capable of invoking infinite code paths.

4372. The software module of aspect 4371, wherein the infinite code paths comprise infinite loops.

4373. The software module of aspect 4370, further including a plurality of operators wherein not one of the plurality of operators is capable of invoking an infinite code path in the software module.

4374. The software module of aspect 4373, wherein the infinite code path comprises an infinite loop.

4375. The software module of aspect 4370, further including a plurality of operators wherein no combination of operators of the plurality of operators are capable of invoking an infinite code path in the software module.

4376. The software module of aspect 4375, wherein the infinite code path comprises an infinite loop.

4377. The software module of aspect 4370, wherein the software module is a written in a modified version of an existing computer language.

4378. The software module of aspect 4377 wherein the existing computer language is one of C, C+, C++, Java, Basic, Pascal, and Fortran.

4379. The software module of aspect 4370 wherein the software module is written in a computer language wherein each operator of a set consisting of all operators in the computer language has unambiguous semantics and is incapable of an invoking infinite code path alone or in combination with other operators.

4380. The software module of aspect 4370 wherein the software module is written in a computer language wherein all modules created in the language have a decidable and complete data flow.

4381. The software module of aspect 4370 wherein the software module is written in a computer language wherein a finite input output semantic model can be generated for any module created in the language.

4382. The software module of aspect 4370 wherein the software module is written in a computer language wherein the software module is written in a computer language wherein each operator of a set consisting of all operators in the computer language is incapable of an invoking infinite code path alone or in combination with other operators.

4383. The software module of aspect 4370, comprising at least 1,000 lines of code.

4384. The software module of aspect 4371, comprising at least 1,000 lines of code.

4385. The software module of aspect 4372, comprising at least 1,000 lines of code.

4386. The software module of aspect 4373, comprising at least 1,000 lines of code.

4387. The software module of aspect 4374, comprising at least 1,000 lines of code.

4388. The software module of aspect 4375, comprising at least 1,000 lines of code.

4389. The software module of aspect 4376, comprising at least 1,000 lines of code.

4390. The software module of aspect 4377, comprising at least 1,000 lines of code.

4391. The software module of aspect 4378, comprising at least 1,000 lines of code.

4392. The software module of aspect 4379, comprising at least 1,000 lines of code.

4393. The software module of aspect 4380, comprising at least 1,000 lines of code.

4394. The software module of aspect 4381, comprising at least 1,000 lines of code.

4395. The software module of aspect 4382, comprising at least 1,000 lines of code.

4396. The software module of aspect 4370, comprising at least 10,000 lines of code.

4397. The software module of aspect 4371, comprising at least 10,000 lines of code.

4398. The software module of aspect 4372, comprising at least 10,000 lines of code.

4399. The software module of aspect 4373, comprising at least 10,000 lines of code.

4400. The software module of aspect 4374, comprising at least 10,000 lines of code.

4401. The software module of aspect 4375, comprising at least 10,000 lines of code.

4402. The software module of aspect 4376, comprising at least 10,000 lines of code.

4403. The software module of aspect 4377, comprising at least 10,000 lines of code.

4404. The software module of aspect 4378, comprising at least 10,000 lines of code.

4405. The software module of aspect 4379, comprising at least 10,000 lines of code.

4406. The software module of aspect 4380, comprising at least 10,000 lines of code.

4407. The software module of aspect 4381, comprising at least 10,000 lines of code.

4408. The software module of aspect 4382, comprising at least 10,000 lines of code.

4409. The software module of aspect 4370, comprising at least 100,000 lines of code.

4410. The software module of aspect 4371, comprising at least 100,000 lines of code.

4411. The software module of aspect 4372, comprising at least 100,000 lines of code.

4412. The software module of aspect 4373, comprising at least 100,000 lines of code.

4413. The software module of aspect 4374, comprising at least 100,000 lines of code.

4414. The software module of aspect 4375, comprising at least 100,000 lines of code.

4415. The software module of aspect 4376, comprising at least 100,000 lines of code.

4416. The software module of aspect 4377, comprising at least 100,000 lines of code.

4417. The software module of aspect 4378, comprising at least 100,000 lines of code.

4418. The software module of aspect 4379, comprising at least 100,000 lines of code.

4419. The software module of aspect 4380, comprising at least 100,000 lines of code.

4420. The software module of aspect 4381, comprising at least 100,000 lines of code.

4421. The software module of aspect 4382, comprising at least 100,000 lines of code.

4422. The software module of aspect 4370, comprising at least 1,000,000 lines of code.

4423. The software module of aspect 4371, comprising at least 1,000,000 lines of code.

4424. The software module of aspect 4372, comprising at least 1,000,000 lines of code.

4425. The software module of aspect 4373, comprising at least 1,000,000 lines of code.

4426. The software module of aspect 4374, comprising at least 1,000,000 lines of code.

4427. The software module of aspect 4375, comprising at least 1,000,000 lines of code.

4428. The software module of aspect 4376, comprising at least 1,000,000 lines of code.

4429. The software module of aspect 4377, comprising at least 1,000,000 lines of code.

4430. The software module of aspect 4378, comprising at least 1,000,000 lines of code.

4431. The software module of aspect 4379, comprising at least 1,000,000 lines of code.

4432. The software module of aspect 4380, comprising at least 1,000,000 lines of code.

4433. The software module of aspect 4381, comprising at least 1,000,000 lines of code.

4434. The software module of aspect 4382, comprising at least 1,000,000 lines of code.

4435. A software module compatible with a finite input output model (FIOSM).

4436. The software module of aspect 4435, wherein the software module does not include operators having ambiguous semantics or operators capable of invoking infinite code paths.

4437. The software module of aspect 4436, wherein the infinite code paths comprise infinite loops.

4438. The software module of aspect 4435, further including a plurality of operators wherein not one of the plurality of operators is capable of invoking an infinite code path in the software module.

4439. The software module of aspect 4438, wherein the infinite code path comprises an infinite loop.

4440. The software module of aspect 4435, further including a plurality of operators wherein no combination of operators of the plurality of operators are capable of invoking an infinite code path in the software module.

4441. The software module of aspect 4440, wherein the infinite code path comprises an infinite loop.

4442. The software module of aspect 4435, wherein the software module is a written in a modified version of an existing computer language.

4443. The software module of aspect 4442 wherein the existing computer language is one of C, C+, C++, Java, Basic, Pascal, and Fortran.

4444. The software module of aspect 4435 wherein the software module is written in a computer language wherein each operator of a set consisting of all operators in the computer language has unambiguous semantics and is incapable of an invoking infinite code path alone or in combination with other operators.

4445. The software module of aspect 4435 wherein the software module is written in a computer language wherein all modules created in the language have a decidable and complete data flow.

4446. The software module of aspect 4435 wherein the software module is written in a computer language wherein a finite input output semantic model can be generated for any module created in the language.

4447. The software module of aspect 4435 wherein the software module is written in a computer language wherein the software module is written in a computer language wherein each operator of a set consisting of all operators in the computer language is incapable of an invoking infinite code path alone or in combination with other operators.

4448. The software module of aspect 4435, comprising at least 1,000 lines of code.

4449. The software module of aspect 4436, comprising at least 1,000 lines of code.

4450. The software module of aspect 4437, comprising at least 1,000 lines of code.

4451. The software module of aspect 4438, comprising at least 1,000 lines of code.

4452. The software module of aspect 4439, comprising at least 1,000 lines of code.

4453. The software module of aspect 4440, comprising at least 1,000 lines of code.

4454. The software module of aspect 4441, comprising at least 1,000 lines of code.

4455. The software module of aspect 4442, comprising at least 1,000 lines of code.

4456. The software module of aspect 4443, comprising at least 1,000 lines of code.

4457. The software module of aspect 4444, comprising at least 1,000 lines of code.

4458. The software module of aspect 4445, comprising at least 1,000 lines of code.

4459. The software module of aspect 4446, comprising at least 1,000 lines of code.

4460. The software module of aspect 4447, comprising at least 1,000 lines of code.

4461. The software module of aspect 4435, comprising at least 10,000 lines of code.

4462. The software module of aspect 4436, comprising at least 10,000 lines of code.

4463. The software module of aspect 4437, comprising at least 10,000 lines of code.

4464. The software module of aspect 4438, comprising at least 10,000 lines of code.

4465. The software module of aspect 4439, comprising at least 10,000 lines of code.

4466. The software module of aspect 4440, comprising at least 10,000 lines of code.

4467. The software module of aspect 4441, comprising at least 10,000 lines of code.

4468. The software module of aspect 4442, comprising at least 10,000 lines of code.

4469. The software module of aspect 4443, comprising at least 10,000 lines of code.

4470. The software module of aspect 4444, comprising at least 10,000 lines of code.

4471. The software module of aspect 4445, comprising at least 10,000 lines of code.

4472. The software module of aspect 4446, comprising at least 10,000 lines of code.

4473. The software module of aspect 4447, comprising at least 10,000 lines of code.

4474. The software module of aspect 4435, comprising at least 100,000 lines of code.

4475. The software module of aspect 4436, comprising at least 100,000 lines of code.

4476. The software module of aspect 4437, comprising at least 100,000 lines of code.

4477. The software module of aspect 4438, comprising at least 100,000 lines of code.

4478. The software module of aspect 4439, comprising at least 100,000 lines of code.

4479. The software module of aspect 4440, comprising at least 100,000 lines of code.

4480. The software module of aspect 4441, comprising at least 100,000 lines of code.

4481. The software module of aspect 4442, comprising at least 100,000 lines of code.

4482. The software module of aspect 4443, comprising at least 100,000 lines of code.

4483. The software module of aspect 4444, comprising at least 100,000 lines of code.

4484. The software module of aspect 4445, comprising at least 100,000 lines of code.

4485. The software module of aspect 4446, comprising at least 100,000 lines of code.

4486. The software module of aspect 4447, comprising at least 100,000 lines of code.

4487. The software module of aspect 4435, comprising at least 1,000,000 lines of code.

4488. The software module of aspect 4436, comprising at least 1,000,000 lines of code.

4489. The software module of aspect 4437, comprising at least 1,000,000 lines of code.

4490. The software module of aspect 4438, comprising at least 1,000,000 lines of code.

4491. The software module of aspect 4439, comprising at least 1,000,000 lines of code.

4492. The software module of aspect 4440, comprising at least 1,000,000 lines of code.

4493. The software module of aspect 4441, comprising at least 1,000,000 lines of code.

4494. The software module of aspect 4442, comprising at least 1,000,000 lines of code.

4495. The software module of aspect 4443, comprising at least 1,000,000 lines of code.

4496. The software module of aspect 4444, comprising at least 1,000,000 lines of code.

4497. The software module of aspect 4445, comprising at least 1,000,000 lines of code.

4498. The software module of aspect 4446, comprising at least 1,000,000 lines of code.

4499. The software module of aspect 4447, comprising at least 1,000,000 lines of code.

4500. A software module wherein a finite input output model (FIOSM) can be generated for the program.

4501. The software module of aspect 4500, wherein the software module does not include operators having ambiguous semantics or operators capable of invoking infinite code paths.

4502. The software module of aspect 4501, wherein the infinite code paths comprise infinite loops.

4503. The software module of aspect 4500, further including a plurality of operators wherein not one of the plurality of operators is capable of invoking an infinite code path in the software module.

4504. The software module of aspect 4503, wherein the infinite code path comprises an infinite loop.

4505. The software module of aspect 4500, further including a plurality of operators wherein no combination of operators of the plurality of operators are capable of invoking an infinite code path in the software module.

4506. The software module of aspect 4505, wherein the infinite code path comprises an infinite loop.

4507. The software module of aspect 4500, wherein the software module is a written in a modified version of an existing computer language.

4508. The software module of aspect 4507 wherein the existing computer language is one of C, C+, C++, Java, Basic, Pascal, and Fortran.

4509. The software module of aspect 4500 wherein the software module is written in a computer language wherein each operator of a set consisting of all operators in the computer language has unambiguous semantics and is incapable of an invoking infinite code path alone or in combination with other operators.

4510. The software module of aspect 4500 wherein the software module is written in a computer language wherein all modules created in the language have a decidable and complete data flow.

4511. The software module of aspect 4500 wherein the software module is written in a computer language wherein a FIOSM can be generated for any module created in the language.

4512. The software module of aspect 4500 wherein the software module is written in a computer language wherein the software module is written in a computer language wherein each operator of a set consisting of all operators in the computer language is incapable of an invoking infinite code path alone or in combination with other operators.

4513. A software module comprising at least 1,000 lines of code wherein a finite input output model (FIOSM) can be generated for the program.

4514. The software module of aspect 4513, wherein the software module does not include operators having ambiguous semantics or operators capable of invoking infinite code paths.

4515. The software module of aspect 4514, wherein the infinite code paths comprise infinite loops.

4516. The software module of aspect 4513, further including a plurality of operators wherein not one of the plurality of operators is capable of invoking an infinite code path in the software module.

4517. The software module of aspect 4516, wherein the infinite code path comprises an infinite loop.

4518. The software module of aspect 4513, further including a plurality of operators wherein no combination of operators of the plurality of operators are capable of invoking an infinite code path in the software module.

4519. The software module of aspect 4518, wherein the infinite code path comprises an infinite loop.

4520. The software module of aspect 4513, wherein the software module is a written in a modified version of an existing computer language.

4521. The software module of aspect 4520 wherein the existing computer language is one of C, C+, C++, Java, Basic, Pascal, and Fortran.

4522. The software module of aspect 4513 wherein the software module is written in a computer language wherein each operator of a set consisting of all operators in the computer language has unambiguous semantics and is incapable of an invoking infinite code path alone or in combination with other operators.

4523. The software module of aspect 4513 wherein the software module is written in a computer language wherein all modules created in the language have a decidable and complete data flow.

4524. The software module of aspect 4513 wherein the software module is written in a computer language wherein a FIOSM can be generated for any module created in the language.

4525. The software module of aspect 4513 wherein the software module is written in a computer language wherein the software module is written in a computer language wherein each operator of a set consisting of all operators in the computer language is incapable of an invoking infinite code path alone or in combination with other operators.

4526. A software module comprising at least 10,000 lines of code wherein a finite input output model (FIOSM) can be generated for the program.

4527. The software module of aspect 4526, wherein the software module does not include operators having ambiguous semantics or operators capable of invoking infinite code paths.

4528. The software module of aspect 4527, wherein the infinite code paths comprise infinite loops.

4529. The software module of aspect 4526, further including a plurality of operators wherein not one of the plurality of operators is capable of invoking an infinite code path in the software module.

4530. The software module of aspect 4529, wherein the infinite code path comprises an infinite loop.

4531. The software module of aspect 4526, further including a plurality of operators wherein no combination of operators of the plurality of operators are capable of invoking an infinite code path in the software module.

4532. The software module of aspect 4531, wherein the infinite code path comprises an infinite loop.

4533. The software module of aspect 4526, wherein the software module is a written in a modified version of an existing computer language.

4534. The software module of aspect 4533 wherein the existing computer language is one of C, C+, C++, Java, Basic, Pascal, and Fortran.

4535. The software module of aspect 4526 wherein the software module is written in a computer language wherein each operator of a set consisting of all operators in the computer language has unambiguous semantics and is incapable of an invoking infinite code path alone or in combination with other operators.

4536. The software module of aspect 4526 wherein the software module is written in a computer language wherein all modules created in the language have a decidable and complete data flow.

4537. The software module of aspect 4526 wherein the software module is written in a computer language wherein a FIOSM can be generated for any module created in the language.

4538. The software module of aspect 4526 wherein the software module is written in a computer language wherein the software module is written in a computer language wherein each operator of a set consisting of all operators in the computer language is incapable of an invoking infinite code path alone or in combination with other operators.

4539. A software module comprising at least 100,000 lines of code wherein a finite input output model (FIOSM) can be generated for the program.

4540. The software module of aspect 4539, wherein the software module does not include control flow operators having ambiguous semantics or control flow operators capable of invoking infinite code paths.

4541. The software module of aspect 4540, wherein the infinite code paths comprise infinite loops.

4542. The software module of aspect 4539, further including a plurality of operators wherein not one of the plurality of operators is capable of invoking an infinite code path in the software module.

4543. The software module of aspect 4542, wherein the infinite code path comprises an infinite loop.

4544. The software module of aspect 4539, further including a plurality of operators wherein no combination of operators of the plurality of operators are capable of invoking an infinite code path in the software module.

4545. The software module of aspect 4544, wherein the infinite code path comprises an infinite loop.

4546. The software module of aspect 4539, wherein the software module is a written in a modified version of an existing computer language.

4547. The software module of aspect 4546 wherein the existing computer language is one of C, C+, C++, Java, Basic, Pascal, and Fortran.

4548. The software module of aspect 4539 wherein the software module is written in a computer language wherein each operator of a set consisting of all operators in the computer language has unambiguous semantics and is incapable of an invoking infinite code path alone or in combination with other operators.

4549. The software module of aspect 4539 wherein the software module is written in a computer language wherein all modules created in the language have a decidable and complete data flow.

4550. The software module of aspect 4539 wherein the software module is written in a computer language wherein a FIOSM can be generated for any module created in the language.

4551. The software module of aspect 4539 wherein the software module is written in a computer language wherein the software module is written in a computer language wherein each operator of a set consisting of all operators in the computer language is incapable of an invoking infinite code path alone or in combination with other operators.

4552. A software module comprising at least 1,000,000 lines of code wherein a finite input output model (FIOSM) can be generated for the program.

4553. The software module of aspect 4552, wherein the software module does not include operators having ambiguous semantics or operators capable of invoking infinite code paths.

4554. The software module of aspect 4553, wherein the infinite code paths comprise infinite loops.

4555. The software module of aspect 4552, further including a plurality of operators wherein not one of the plurality of operators is capable of invoking an infinite code path in the software module.

4556. The software module of aspect 4555, wherein the infinite code path comprises an infinite loop.

4557. The software module of aspect 4552, further including a plurality of operators wherein no combination of operators of the plurality of operators are capable of invoking an infinite code path in the software module.

4558. The software module of aspect 4557, wherein the infinite code path comprises an infinite loop.

4559. The software module of aspect 4552, wherein the software module is a written in a modified version of an existing computer language.

4560. The software module of aspect 4559 wherein the existing computer language is one of C, C+, C++, Java, Basic, Pascal, and Fortran.

4561. The software module of aspect 4552 wherein the software module is written in a computer language wherein each operator of a set consisting of all operators in the computer language has unambiguous semantics and is incapable of an invoking infinite code path alone or in combination with other operators.

4562. The software module of aspect 4552 wherein the software module is written in a computer language wherein all modules created in the language have a decidable and complete data flow.

4563. The software module of aspect 4552 wherein the software module is written in a computer language wherein a FIOSM can be generated for any module created in the language.

4564. The software module of aspect 4552 wherein the software module is written in a computer language wherein the software module is written in a computer language wherein each operator of a set consisting of all operators in the computer language is incapable of an invoking infinite code path alone or in combination with other operators.

4565. A software procedure governed by a finite input/output semantic (FIOSM) model.

4566. The software procedure of aspect 4565, wherein the software procedure does not include operators having ambiguous semantics or operators capable of invoking infinite code paths.

4567. The software procedure of aspect 4566, wherein the infinite code paths comprise infinite loops.

4568. The software procedure of aspect 4565, further including a plurality of operators wherein not one of the plurality of operators is capable of invoking an infinite code path in the software procedure.

4569. The software procedure of aspect 4568, wherein the infinite code path comprises an infinite loop.

4570. The software procedure of aspect 4565, further including a plurality of operators wherein no combination of operators of the plurality of operators are capable of invoking an infinite code path in the software procedure.

4571. The software procedure of aspect 4570, wherein the infinite code path comprises an infinite loop.

4572. The software procedure of aspect 4565, wherein the software procedure is a written in a modified version of a preexisting computer language, the modified version having a decidable and complete data flow.

4573. The software procedure of aspect 4572 wherein the existing computer language is one of C, C+, C++, Java, Basic, Pascal, and Fortran.

4574. The software procedure of aspect 4565 wherein the software procedure is written in a computer language wherein each operator of a set consisting of all operators in the computer language has unambiguous semantics and is incapable of an invoking infinite code path alone or in combination with other operators.

4575. The software procedure of aspect 4565 wherein the software procedure is written in a computer language wherein all procedures created in the language have a decidable and complete data flow.

4576. The software procedure of aspect 4565 wherein the software procedure is written in a computer language wherein a finite input output semantic model can be generated for any procedure created in the language.

4577. The software procedure of aspect 4565 wherein the software procedure is written in a computer language wherein the software procedure is written in a computer language wherein each operator of a set consisting of all operators in the computer language is incapable of an invoking infinite code path alone or in combination with other operators.

4578. The software procedure of aspect 4565, comprising at least 1,000 lines of code.

4579. The software procedure of aspect 4566, comprising at least 1,000 lines of code.

4580. The software procedure of aspect 4567, comprising at least 1,000 lines of code.

4581. The software procedure of aspect 4568, comprising at least 1,000 lines of code.

4582. The software procedure of aspect 4569, comprising at least 1,000 lines of code.

4583. The software procedure of aspect 4570, comprising at least 1,000 lines of code.

4584. The software procedure of aspect 4571, comprising at least 1,000 lines of code.

4585. The software procedure of aspect 4572, comprising at least 1,000 lines of code.

4586. The software procedure of aspect 4573, comprising at least 1,000 lines of code.

4587. The software procedure of aspect 4574, comprising at least 1,000 lines of code.

4588. The software procedure of aspect 4575, comprising at least 1,000 lines of code.

4589. The software procedure of aspect 4576, comprising at least 1,000 lines of code.

4590. The software procedure of aspect 4577, comprising at least 1,000 lines of code.

4591. The software procedure of aspect 4565, comprising at least 10,000 lines of code.

4592. The software procedure of aspect 4566, comprising at least 10,000 lines of code.

4593. The software procedure of aspect 4567, comprising at least 10,000 lines of code.

4594. The software procedure of aspect 4568, comprising at least 10,000 lines of code.

4595. The software procedure of aspect 4569, comprising at least 10,000 lines of code.

4596. The software procedure of aspect 4570, comprising at least 10,000 lines of code.

4597. The software procedure of aspect 4571, comprising at least 10,000 lines of code.

4598. The software procedure of aspect 4572, comprising at least 10,000 lines of code.

4599. The software procedure of aspect 4573, comprising at least 10,000 lines of code.

4600. The software procedure of aspect 4574, comprising at least 10,000 lines of code.

4601. The software procedure of aspect 4575, comprising at least 10,000 lines of code.

4602. The software procedure of aspect 4576, comprising at least 10,000 lines of code.

4603. The software procedure of aspect 4577, comprising at least 10,000 lines of code.

4604. The software procedure of aspect 4565, comprising at least 100,000 lines of code.

4605. The software procedure of aspect 4566, comprising at least 100,000 lines of code.

4606. The software procedure of aspect 4567, comprising at least 100,000 lines of code.

4607. The software procedure of aspect 4568, comprising at least 100,000 lines of code.

4608. The software procedure of aspect 4569, comprising at least 100,000 lines of code.

4609. The software procedure of aspect 4570, comprising at least 100,000 lines of code.

4610. The software procedure of aspect 4571, comprising at least 100,000 lines of code.

4611. The software procedure of aspect 4572, comprising at least 100,000 lines of code.

4612. The software procedure of aspect 4573, comprising at least 100,000 lines of code.

4613. The software procedure of aspect 4574, comprising at least 100,000 lines of code.

4614. The software procedure of aspect 4575, comprising at least 100,000 lines of code.

4615. The software procedure of aspect 4576, comprising at least 100,000 lines of code.

4616. The software procedure of aspect 4577, comprising at least 100,000 lines of code.

4617. The software procedure of aspect 4565, comprising at least 1,000,000 lines of code.

4618. The software procedure of aspect 4566, comprising at least 1,000,000 lines of code.

4619. The software procedure of aspect 4567, comprising at least 1,000,000 lines of code.

4620. The software procedure of aspect 4568, comprising at least 1,000,000 lines of code.

4621. The software procedure of aspect 4569, comprising at least 1,000,000 lines of code.

4622. The software procedure of aspect 4570, comprising at least 1,000,000 lines of code.

4623. The software procedure of aspect 4571, comprising at least 1,000,000 lines of code.

4624. The software procedure of aspect 4572, comprising at least 1,000,000 lines of code.

4625. The software procedure of aspect 4573, comprising at least 1,000,000 lines of code.

4626. The software procedure of aspect 4574, comprising at least 1,000,000 lines of code.

4627. The software procedure of aspect 4575, comprising at least 1,000,000 lines of code.

4628. The software procedure of aspect 4576, comprising at least 1,000,000 lines of code.

4629. The software procedure of aspect 4577, comprising at least 1,000,000 lines of code.

4630. A software procedure wherein all outputs can be mapped to all inputs.

4631. The software procedure of aspect 4630, wherein the software procedure does not include operators having ambiguous semantics or operators capable of invoking infinite code paths.

4632. The software procedure of aspect 4631, wherein the infinite code paths comprise infinite loops.

4633. The software procedure of aspect 4630, further including a plurality of operators wherein not one of the plurality of operators is capable of invoking an infinite code path in the software procedure.

4634. The software procedure of aspect 4633, wherein the infinite code path comprises an infinite loop.

4635. The software procedure of aspect 4630, further including a plurality of operators wherein no combination of operators of the plurality of operators are capable of invoking an infinite code path in the software procedure.

4636. The software procedure of aspect 4635, wherein the infinite code path comprises an infinite loop.

4637. The software procedure of aspect 4630, wherein the software procedure is a written in a modified version of an existing computer language.

4638. The software procedure of aspect 4637 wherein the existing computer language is one of C, C+, C++, Java, Basic, Pascal, and Fortran.

4639. The software procedure of aspect 4630 wherein the software procedure is written in a computer language wherein each operator of a set consisting of all operators in the computer language has unambiguous semantics and is incapable of an invoking infinite code path alone or in combination with other operators.

4640. The software procedure of aspect 4630 wherein the software procedure is written in a computer language wherein all procedures created in the language have a decidable and complete data flow.

4641. The software procedure of aspect 4630 wherein the software procedure is written in a computer language wherein a finite input output semantic model can be generated for any procedure created in the language.

4642. The software procedure of aspect 4630 wherein the software procedure is written in a computer language wherein the software procedure is written in a computer language wherein each operator of a set consisting of all operators in the computer language is incapable of an invoking infinite code path alone or in combination with other operators.

4643. The software procedure of aspect 4630, comprising at least 1,000 lines of code.

4644. The software procedure of aspect 4631, comprising at least 1,000 lines of code.

4645. The software procedure of aspect 4632, comprising at least 1,000 lines of code.

4646. The software procedure of aspect 4633, comprising at least 1,000 lines of code.

4647. The software procedure of aspect 4634, comprising at least 1,000 lines of code.

4648. The software procedure of aspect 4635, comprising at least 1,000 lines of code.

4649. The software procedure of aspect 4636, comprising at least 1,000 lines of code.

4650. The software procedure of aspect 4637, comprising at least 1,000 lines of code.

4651. The software procedure of aspect 4638, comprising at least 1,000 lines of code.

4652. The software procedure of aspect 4639, comprising at least 1,000 lines of code.

4653. The software procedure of aspect 4640, comprising at least 1,000 lines of code.

4654. The software procedure of aspect 4641, comprising at least 1,000 lines of code.

4655. The software procedure of aspect 4642, comprising at least 1,000 lines of code.

4656. The software procedure of aspect 4630, comprising at least 10,000 lines of code.

4657. The software procedure of aspect 4631, comprising at least 10,000 lines of code.

4658. The software procedure of aspect 4632, comprising at least 10,000 lines of code.

4659. The software procedure of aspect 4633, comprising at least 10,000 lines of code.

4660. The software procedure of aspect 4634, comprising at least 10,000 lines of code.

4661. The software procedure of aspect 4635, comprising at least 10,000 lines of code.

4662. The software procedure of aspect 4636, comprising at least 10,000 lines of code.

4663. The software procedure of aspect 4637, comprising at least 10,000 lines of code.

4664. The software procedure of aspect 4638, comprising at least 10,000 lines of code.

4665. The software procedure of aspect 4639, comprising at least 10,000 lines of code.

4666. The software procedure of aspect 4640, comprising at least 10,000 lines of code.

4667. The software procedure of aspect 4641, comprising at least 10,000 lines of code.

4668. The software procedure of aspect 4642, comprising at least 10,000 lines of code.

4669. The software procedure of aspect 4630, comprising at least 100,000 lines of code.

4670. The software procedure of aspect 4631, comprising at least 100,000 lines of code.

4671. The software procedure of aspect 4632, comprising at least 100,000 lines of code.

4672. The software procedure of aspect 4633, comprising at least 100,000 lines of code.

4673. The software procedure of aspect 4634, comprising at least 100,000 lines of code.

4674. The software procedure of aspect 4635, comprising at least 100,000 lines of code.

4675. The software procedure of aspect 4636, comprising at least 100,000 lines of code.

4676. The software procedure of aspect 4637, comprising at least 100,000 lines of code.

4677. The software procedure of aspect 4638, comprising at least 100,000 lines of code.

4678. The software procedure of aspect 4639, comprising at least 100,000 lines of code.

4679. The software procedure of aspect 4640, comprising at least 100,000 lines of code.

4680. The software procedure of aspect 4641, comprising at least 100,000 lines of code.

4681. The software procedure of aspect 4642, comprising at least 100,000 lines of code.

4682. The software procedure of aspect 4630, comprising at least 1,000,000 lines of code.

4683. The software procedure of aspect 4631, comprising at least 1,000,000 lines of code.

4684. The software procedure of aspect 4632, comprising at least 1,000,000 lines of code.

4685. The software procedure of aspect 4633, comprising at least 1,000,000 lines of code.

4686. The software procedure of aspect 4634, comprising at least 1,000,000 lines of code.

4687. The software procedure of aspect 4635, comprising at least 1,000,000 lines of code.

4688. The software procedure of aspect 4636, comprising at least 1,000,000 lines of code.

4689. The software procedure of aspect 4637, comprising at least 1,000,000 lines of code.

4690. The software procedure of aspect 4638, comprising at least 1,000,000 lines of code.

4691. The software procedure of aspect 4639, comprising at least 1,000,000 lines of code.

4692. The software procedure of aspect 4640, comprising at least 1,000,000 lines of code.

4693. The software procedure of aspect 4641, comprising at least 1,000,000 lines of code.

4694. The software procedure of aspect 4642, comprising at least 1,000,000 lines of code.

4695. A software procedure having a finite set of input and output patterns.

4696. The software procedure of aspect 4695, wherein the software procedure does not include operators having ambiguous semantics or operators capable of invoking infinite code paths.

4697. The software procedure of aspect 4696, wherein the infinite code paths comprise infinite loops.

4698. The software procedure of aspect 4695, further including a plurality of operators wherein not one of the plurality of operators is capable of invoking an infinite code path in the software procedure.

4699. The software procedure of aspect 4698, wherein the infinite code path comprises an infinite loop.

4700. The software procedure of aspect 4695, further including a plurality of operators wherein no combination of operators of the plurality of operators are capable of invoking an infinite code path in the software procedure.

4701. The software procedure of aspect 4700, wherein the infinite code path comprises an infinite loop.

4702. The software procedure of aspect 4695, wherein the software procedure is a written in a modified version of an existing computer language.

4703. The software procedure of aspect 4702 wherein the existing computer language is one of C, C+, C++, Java, Basic, Pascal, and Fortran.

4704. The software procedure of aspect 4695 wherein the software procedure is written in a computer language wherein each operator of a set consisting of all operators in the computer language has unambiguous semantics and is incapable of an invoking infinite code path alone or in combination with other operators.

4705. The software procedure of aspect 4695 wherein the software procedure is written in a computer language wherein all procedures created in the language have a decidable and complete data flow.

4706. The software procedure of aspect 4695 wherein the software procedure is written in a computer language wherein a finite input output semantic model can be generated for any procedure created in the language.

4707. The software procedure of aspect 4695 wherein the software procedure is written in a computer language wherein the software procedure is written in a computer language wherein each operator of a set consisting of all operators in the computer language is incapable of an invoking infinite code path alone or in combination with other operators.

4708. The software procedure of aspect 4695, comprising at least 1,000 lines of code.

4709. The software procedure of aspect 4696, comprising at least 1,000 lines of code.

4710. The software procedure of aspect 4697, comprising at least 1,000 lines of code.

4711. The software procedure of aspect 4698, comprising at least 1,000 lines of code.

4712. The software procedure of aspect 4699, comprising at least 1,000 lines of code.

4713. The software procedure of aspect 4700, comprising at least 1,000 lines of code.

4714. The software procedure of aspect 4701, comprising at least 1,000 lines of code.

4715. The software procedure of aspect 4702, comprising at least 1,000 lines of code.

4716. The software procedure of aspect 4703, comprising at least 1,000 lines of code.

4717. The software procedure of aspect 4704, comprising at least 1,000 lines of code.

4718. The software procedure of aspect 4705, comprising at least 1,000 lines of code.

4719. The software procedure of aspect 4706, comprising at least 1,000 lines of code.

4720. The software procedure of aspect 4707, comprising at least 1,000 lines of code.

4721. The software procedure of aspect 4695, comprising at least 10,000 lines of code.

4722. The software procedure of aspect 4696, comprising at least 10,000 lines of code.

4723. The software procedure of aspect 4697, comprising at least 10,000 lines of code.

4724. The software procedure of aspect 4698, comprising at least 10,000 lines of code.

4725. The software procedure of aspect 4699, comprising at least 10,000 lines of code.

4726. The software procedure of aspect 4700, comprising at least 10,000 lines of code.

4727. The software procedure of aspect 4701, comprising at least 10,000 lines of code.

4728. The software procedure of aspect 4702, comprising at least 10,000 lines of code.

4729. The software procedure of aspect 4703, comprising at least 10,000 lines of code.

4730. The software procedure of aspect 4704, comprising at least 10,000 lines of code.

4731. The software procedure of aspect 4705, comprising at least 10,000 lines of code.

4732. The software procedure of aspect 4706, comprising at least 10,000 lines of code.

4733. The software procedure of aspect 4707, comprising at least 10,000 lines of code.

4734. The software procedure of aspect 4695, comprising at least 100,000 lines of code.

4735. The software procedure of aspect 4696, comprising at least 100,000 lines of code.

4736. The software procedure of aspect 4697, comprising at least 100,000 lines of code.

4737. The software procedure of aspect 4698, comprising at least 100,000 lines of code.

4738. The software procedure of aspect 4699, comprising at least 100,000 lines of code.

4739. The software procedure of aspect 4700, comprising at least 100,000 lines of code.

4740. The software procedure of aspect 4701, comprising at least 100,000 lines of code.

4741. The software procedure of aspect 4702, comprising at least 100,000 lines of code.

4742. The software procedure of aspect 4703, comprising at least 100,000 lines of code.

4743. The software procedure of aspect 4704, comprising at least 100,000 lines of code.

4744. The software procedure of aspect 4705, comprising at least 100,000 lines of code.

4745. The software procedure of aspect 4706, comprising at least 100,000 lines of code.

4746. The software procedure of aspect 4707, comprising at least 100,000 lines of code.

4747. The software procedure of aspect 4695, comprising at least 1,000,000 lines of code.

4748. The software procedure of aspect 4696, comprising at least 1,000,000 lines of code.

4749. The software procedure of aspect 4697, comprising at least 1,000,000 lines of code.

4750. The software procedure of aspect 4698, comprising at least 1,000,000 lines of code.

4751. The software procedure of aspect 4699, comprising at least 1,000,000 lines of code.

4752. The software procedure of aspect 4700, comprising at least 1,000,000 lines of code.

4753. The software procedure of aspect 4701, comprising at least 1,000,000 lines of code.

4754. The software procedure of aspect 4702, comprising at least 1,000,000 lines of code.

4755. The software procedure of aspect 4703, comprising at least 1,000,000 lines of code.

4756. The software procedure of aspect 4704, comprising at least 1,000,000 lines of code.

4757. The software procedure of aspect 4705, comprising at least 1,000,000 lines of code.

4758. The software procedure of aspect 4706, comprising at least 1,000,000 lines of code.

4759. The software procedure of aspect 4707, comprising at least 1,000,000 lines of code.

4760. A software procedure having completely decidable data flow.

4761. The software procedure of aspect 4760, wherein the software procedure does not include operators having ambiguous semantics or operators capable of invoking infinite code paths.

4762. The software procedure of aspect 4761, wherein the infinite code paths comprise infinite loops.

4763. The software procedure of aspect 4760, further including a plurality of operators wherein not one of the plurality of operators is capable of invoking an infinite code path in the software procedure.

4764. The software procedure of aspect 4763, wherein the infinite code path comprises an infinite loop.

4765. The software procedure of aspect 4760, further including a plurality of operators wherein no combination of operators of the plurality of operators are capable of invoking an infinite code path in the software procedure.

4766. The software procedure of aspect 4765, wherein the infinite code path comprises an infinite loop.

4767. The software procedure of aspect 4760, wherein the software procedure is a written in a modified version of an existing computer language.

4768. The software procedure of aspect 4767 wherein the existing computer language is one of C, C+, C++, Java, Basic, Pascal, and Fortran.

4769. The software procedure of aspect 4760 wherein the software procedure is written in a computer language wherein each operator of a set consisting of all operators in the computer language has unambiguous semantics and is incapable of an invoking infinite code path alone or in combination with other operators.

4770. The software procedure of aspect 4760 wherein the software procedure is written in a computer language wherein all procedures created in the language have a decidable and complete data flow.

4771. The software procedure of aspect 4760 wherein the software procedure is written in a computer language wherein a finite input output semantic model can be generated for any procedure created in the language.

4772. The software procedure of aspect 4760 wherein the software procedure is written in a computer language wherein the software procedure is written in a computer language wherein each operator of a set consisting of all operators in the computer language is incapable of an invoking infinite code path alone or in combination with other operators.

4773. The software procedure of aspect 4760, comprising at least 1,000 lines of code.

4774. The software procedure of aspect 4761, comprising at least 1,000 lines of code.

4775. The software procedure of aspect 4762, comprising at least 1,000 lines of code.

4776. The software procedure of aspect 4763, comprising at least 1,000 lines of code.

4777. The software procedure of aspect 4764, comprising at least 1,000 lines of code.

4778. The software procedure of aspect 4765, comprising at least 1,000 lines of code.

4779. The software procedure of aspect 4766, comprising at least 1,000 lines of code.

4780. The software procedure of aspect 4767, comprising at least 1,000 lines of code.

4781. The software procedure of aspect 4768, comprising at least 1,000 lines of code.

4782. The software procedure of aspect 4769, comprising at least 1,000 lines of code.

4783. The software procedure of aspect 4770, comprising at least 1,000 lines of code.

4784. The software procedure of aspect 4771, comprising at least 1,000 lines of code.

4785. The software procedure of aspect 4772, comprising at least 1,000 lines of code.

4786. The software procedure of aspect 4760, comprising at least 10,000 lines of code.

4787. The software procedure of aspect 4761, comprising at least 10,000 lines of code.

4788. The software procedure of aspect 4762, comprising at least 10,000 lines of code.

4789. The software procedure of aspect 4763, comprising at least 10,000 lines of code.

4790. The software procedure of aspect 4764, comprising at least 10,000 lines of code.

4791. The software procedure of aspect 4765, comprising at least 10,000 lines of code.

4792. The software procedure of aspect 4766, comprising at least 10,000 lines of code.

4793. The software procedure of aspect 4767, comprising at least 10,000 lines of code.

4794. The software procedure of aspect 4768, comprising at least 10,000 lines of code.

4795. The software procedure of aspect 4769, comprising at least 10,000 lines of code.

4796. The software procedure of aspect 4770, comprising at least 10,000 lines of code.

4797. The software procedure of aspect 4771, comprising at least 10,000 lines of code.

4798. The software procedure of aspect 4772, comprising at least 10,000 lines of code.

4799. The software procedure of aspect 4760, comprising at least 100,000 lines of code.

4800. The software procedure of aspect 4761, comprising at least 100,000 lines of code.

4801. The software procedure of aspect 4762, comprising at least 100,000 lines of code.

4802. The software procedure of aspect 4763, comprising at least 100,000 lines of code.

4803. The software procedure of aspect 4764, comprising at least 100,000 lines of code.

4804. The software procedure of aspect 4765, comprising at least 100,000 lines of code.

4805. The software procedure of aspect 4766, comprising at least 100,000 lines of code.

4806. The software procedure of aspect 4767, comprising at least 100,000 lines of code.

4807. The software procedure of aspect 4768, comprising at least 100,000 lines of code.

4808. The software procedure of aspect 4769, comprising at least 100,000 lines of code.

4809. The software procedure of aspect 4770, comprising at least 100,000 lines of code.

4810. The software procedure of aspect 4771, comprising at least 100,000 lines of code.

4811. The software procedure of aspect 4772, comprising at least 100,000 lines of code.

4812. The software procedure of aspect 4760, comprising at least 1,000,000 lines of code.

4813. The software procedure of aspect 4761, comprising at least 1,000,000 lines of code.

4814. The software procedure of aspect 4762, comprising at least 1,000,000 lines of code.

4815. The software procedure of aspect 4763, comprising at least 1,000,000 lines of code.

4816. The software procedure of aspect 4764, comprising at least 1,000,000 lines of code.

4817. The software procedure of aspect 4765, comprising at least 1,000,000 lines of code.

4818. The software procedure of aspect 4766, comprising at least 1,000,000 lines of code.

4819. The software procedure of aspect 4767, comprising at least 1,000,000 lines of code.

4820. The software procedure of aspect 4768, comprising at least 1,000,000 lines of code.

4821. The software procedure of aspect 4769, comprising at least 1,000,000 lines of code.

4822. The software procedure of aspect 4770, comprising at least 1,000,000 lines of code.

4823. The software procedure of aspect 4771, comprising at least 1,000,000 lines of code.

4824. The software procedure of aspect 4772, comprising at least 1,000,000 lines of code.

4825. A software procedure embodying the finite code path property.

4826. The software procedure of aspect 4825, wherein the software procedure does not include operators having ambiguous semantics or operators capable of invoking infinite code paths.

4827. The software procedure of aspect 4826, wherein the infinite code paths comprise infinite loops.

4828. The software procedure of aspect 4825, further including a plurality of operators wherein not one of the plurality of operators is capable of invoking an infinite code path in the software procedure.

4829. The software procedure of aspect 4828, wherein the infinite code path comprises an infinite loop.

4830. The software procedure of aspect 4825, further including a plurality of operators wherein no combination of operators of the plurality of operators are capable of invoking an infinite code path in the software procedure.

4831. The software procedure of aspect 4830, wherein the infinite code path comprises an infinite loop.

4832. The software procedure of aspect 4825, wherein the software procedure is a written in a modified version of an existing computer language.

4833. The software procedure of aspect 4832 wherein the existing computer language is one of C, C+, C++, Java, Basic, Pascal, and Fortran.

4834. The software procedure of aspect 4825 wherein the software procedure is written in a computer language wherein each operator of a set consisting of all operators in the computer language has unambiguous semantics and is incapable of an invoking infinite code path alone or in combination with other operators.

4835. The software procedure of aspect 4825 wherein the software procedure is written in a computer language wherein all procedures created in the language have a decidable and complete data flow.

4836. The software procedure of aspect 4825 wherein the software procedure is written in a computer language wherein a finite input output semantic model can be generated for any procedure created in the language.

4837. The software procedure of aspect 4825 wherein the software procedure is written in a computer language wherein the software procedure is written in a computer language wherein each operator of a set consisting of all operators in the computer language is incapable of an invoking infinite code path alone or in combination with other operators.

4838. The software procedure of aspect 4825, comprising at least 1,000 lines of code.

4839. The software procedure of aspect 4826, comprising at least 1,000 lines of code.

4840. The software procedure of aspect 4827, comprising at least 1,000 lines of code.

4841. The software procedure of aspect 4828, comprising at least 1,000 lines of code.

4842. The software procedure of aspect 4829, comprising at least 1,000 lines of code.

4843. The software procedure of aspect 4830, comprising at least 1,000 lines of code.

4844. The software procedure of aspect 4831, comprising at least 1,000 lines of code.

4845. The software procedure of aspect 4832, comprising at least 1,000 lines of code.

4846. The software procedure of aspect 4833, comprising at least 1,000 lines of code.

4847. The software procedure of aspect 4834, comprising at least 1,000 lines of code.

4848. The software procedure of aspect 4835, comprising at least 1,000 lines of code.

4849. The software procedure of aspect 4836, comprising at least 1,000 lines of code.

4850. The software procedure of aspect 4837, comprising at least 1,000 lines of code.

4851. The software procedure of aspect 4825, comprising at least 10,000 lines of code.

4852. The software procedure of aspect 4826, comprising at least 10,000 lines of code.

4853. The software procedure of aspect 4827, comprising at least 10,000 lines of code.

4854. The software procedure of aspect 4828, comprising at least 10,000 lines of code.

4855. The software procedure of aspect 4829, comprising at least 10,000 lines of code.

4856. The software procedure of aspect 4830, comprising at least 10,000 lines of code.

4857. The software procedure of aspect 4831, comprising at least 10,000 lines of code.

4858. The software procedure of aspect 4832, comprising at least 10,000 lines of code.

4859. The software procedure of aspect 4833, comprising at least 10,000 lines of code.

4860. The software procedure of aspect 4834, comprising at least 10,000 lines of code.

4861. The software procedure of aspect 4835, comprising at least 10,000 lines of code.

4862. The software procedure of aspect 4836, comprising at least 10,000 lines of code.

4863. The software procedure of aspect 4837, comprising at least 10,000 lines of code.

4864. The software procedure of aspect 4825, comprising at least 100,000 lines of code.

4865. The software procedure of aspect 4826, comprising at least 100,000 lines of code.

4866. The software procedure of aspect 4827, comprising at least 100,000 lines of code.

4867. The software procedure of aspect 4828, comprising at least 100,000 lines of code.

4868. The software procedure of aspect 4829, comprising at least 100,000 lines of code.

4869. The software procedure of aspect 4830, comprising at least 100,000 lines of code.

4870. The software procedure of aspect 4831, comprising at least 100,000 lines of code.

4871. The software procedure of aspect 4832, comprising at least 100,000 lines of code.

4872. The software procedure of aspect 4833, comprising at least 100,000 lines of code.

4873. The software procedure of aspect 4834, comprising at least 100,000 lines of code.

4874. The software procedure of aspect 4835, comprising at least 100,000 lines of code.

4875. The software procedure of aspect 4836, comprising at least 100,000 lines of code.

4876. The software procedure of aspect 4837, comprising at least 100,000 lines of code.

4877. The software procedure of aspect 4825, comprising at least 1,000,000 lines of code.

4878. The software procedure of aspect 4826, comprising at least 1,000,000 lines of code.

4879. The software procedure of aspect 4827, comprising at least 1,000,000 lines of code.

4880. The software procedure of aspect 4828, comprising at least 1,000,000 lines of code.

4881. The software procedure of aspect 4829, comprising at least 1,000,000 lines of code.

4882. The software procedure of aspect 4830, comprising at least 1,000,000 lines of code.

4883. The software procedure of aspect 4831, comprising at least 1,000,000 lines of code.

4884. The software procedure of aspect 4832, comprising at least 1,000,000 lines of code.

4885. The software procedure of aspect 4833, comprising at least 1,000,000 lines of code.

4886. The software procedure of aspect 4834, comprising at least 1,000,000 lines of code.

4887. The software procedure of aspect 4835, comprising at least 1,000,000 lines of code.

4888. The software procedure of aspect 4836, comprising at least 1,000,000 lines of code.

4889. The software procedure of aspect 4837, comprising at least 1,000,000 lines of code.

4890. A software procedure compatible with a finite input output model (FIOSM).

4891. The software procedure of aspect 4890, wherein the software procedure does not include operators having ambiguous semantics or operators capable of invoking infinite code paths.

4892. The software procedure of aspect 4891, wherein the infinite code paths comprise infinite loops.

4893. The software procedure of aspect 4890, further including a plurality of operators wherein not one of the plurality of operators is capable of invoking an infinite code path in the software procedure.

4894. The software procedure of aspect 4893, wherein the infinite code path comprises an infinite loop.

4895. The software procedure of aspect 4890, further including a plurality of operators wherein no combination of operators of the plurality of operators are capable of invoking an infinite code path in the software procedure.

4896. The software procedure of aspect 4895, wherein the infinite code path comprises an infinite loop.

4897. The software procedure of aspect 4890, wherein the software procedure is a written in a modified version of an existing computer language.

4898. The software procedure of aspect 4897 wherein the existing computer language is one of C, C+, C++, Java, Basic, Pascal, and Fortran.

4899. The software procedure of aspect 4890 wherein the software procedure is written in a computer language wherein each operator of a set consisting of all operators in the computer language has unambiguous semantics and is incapable of an invoking infinite code path alone or in combination with other operators.

4900. The software procedure of aspect 4890 wherein the software procedure is written in a computer language wherein all procedures created in the language have a decidable and complete data flow.

4901. The software procedure of aspect 4890 wherein the software procedure is written in a computer language wherein a finite input output semantic model can be generated for any procedure created in the language.

4902. The software procedure of aspect 4890 wherein the software procedure is written in a computer language wherein the software procedure is written in a computer language wherein each operator of a set consisting of all operators in the computer language is incapable of an invoking infinite code path alone or in combination with other operators.

4903. The software procedure of aspect 4890, comprising at least 1,000 lines of code.

4904. The software procedure of aspect 4891, comprising at least 1,000 lines of code.

4905. The software procedure of aspect 4892, comprising at least 1,000 lines of code.

4906. The software procedure of aspect 4893, comprising at least 1,000 lines of code.

4907. The software procedure of aspect 4894, comprising at least 1,000 lines of code.

4908. The software procedure of aspect 4895, comprising at least 1,000 lines of code.

4909. The software procedure of aspect 4896, comprising at least 1,000 lines of code.

4910. The software procedure of aspect 4897, comprising at least 1,000 lines of code.

4911. The software procedure of aspect 4898, comprising at least 1,000 lines of code.

4912. The software procedure of aspect 4899, comprising at least 1,000 lines of code.

4913. The software procedure of aspect 4900, comprising at least 1,000 lines of code.

4914. The software procedure of aspect 4901, comprising at least 1,000 lines of code.

4915. The software procedure of aspect 4902, comprising at least 1,000 lines of code.

4916. The software procedure of aspect 4890, comprising at least 10,000 lines of code.

4917. The software procedure of aspect 4891, comprising at least 10,000 lines of code.

4918. The software procedure of aspect 4892, comprising at least 10,000 lines of code.

4919. The software procedure of aspect 4893, comprising at least 10,000 lines of code.

4920. The software procedure of aspect 4894, comprising at least 10,000 lines of code.

4921. The software procedure of aspect 4895, comprising at least 10,000 lines of code.

4922. The software procedure of aspect 4896, comprising at least 10,000 lines of code.

4923. The software procedure of aspect 4897, comprising at least 10,000 lines of code.

4924. The software procedure of aspect 4898, comprising at least 10,000 lines of code.

4925. The software procedure of aspect 4899, comprising at least 10,000 lines of code.

4926. The software procedure of aspect 4900, comprising at least 10,000 lines of code.

4927. The software procedure of aspect 4901, comprising at least 10,000 lines of code.

4928. The software procedure of aspect 4902, comprising at least 10,000 lines of code.

4929. The software procedure of aspect 4890, comprising at least 100,000 lines of code.

4930. The software procedure of aspect 4891, comprising at least 100,000 lines of code.

4931. The software procedure of aspect 4892, comprising at least 100,000 lines of code.

4932. The software procedure of aspect 4893, comprising at least 100,000 lines of code.

4933. The software procedure of aspect 4894, comprising at least 100,000 lines of code.

4934. The software procedure of aspect 4895, comprising at least 100,000 lines of code.

4935. The software procedure of aspect 4896, comprising at least 100,000 lines of code.

4936. The software procedure of aspect 4897, comprising at least 100,000 lines of code.

4937. The software procedure of aspect 4898, comprising at least 100,000 lines of code.

4938. The software procedure of aspect 4899, comprising at least 100,000 lines of code.

4939. The software procedure of aspect 4900, comprising at least 100,000 lines of code.

4940. The software procedure of aspect 4901, comprising at least 100,000 lines of code.

4941. The software procedure of aspect 4902, comprising at least 100,000 lines of code.

4942. The software procedure of aspect 4890, comprising at least 1,000,000 lines of code.

4943. The software procedure of aspect 4891, comprising at least 1,000,000 lines of code.

4944. The software procedure of aspect 4892, comprising at least 1,000,000 lines of code.

4945. The software procedure of aspect 4893, comprising at least 1,000,000 lines of code.

4946. The software procedure of aspect 4894, comprising at least 1,000,000 lines of code.

4947. The software procedure of aspect 4895, comprising at least 1,000,000 lines of code.

4948. The software procedure of aspect 4896, comprising at least 1,000,000 lines of code.

4949. The software procedure of aspect 4897, comprising at least 1,000,000 lines of code.

4950. The software procedure of aspect 4898, comprising at least 1,000,000 lines of code.

4951. The software procedure of aspect 4899, comprising at least 1,000,000 lines of code.

4952. The software procedure of aspect 4900, comprising at least 1,000,000 lines of code.

4953. The software procedure of aspect 4901, comprising at least 1,000,000 lines of code.

4954. The software procedure of aspect 4902, comprising at least 1,000,000 lines of code.

4955. A software procedure wherein a finite input output model (FIOSM) can be generated for the software procedure.

4956. The software procedure of aspect 4955, wherein the software procedure does not include operators having ambiguous semantics or operators capable of invoking infinite code paths.

4957. The software procedure of aspect 4956, wherein the infinite code paths comprise infinite loops.

4958. The software procedure of aspect 4955, further including a plurality of operators wherein not one of the plurality of operators is capable of invoking an infinite code path in the software procedure.

4959. The software procedure of aspect 4958, wherein the infinite code path comprises an infinite loop.

4960. The software procedure of aspect 4955, further including a plurality of operators wherein no combination of operators of the plurality of operators are capable of invoking an infinite code path in the software procedure.

4961. The software procedure of aspect 4960, wherein the infinite code path comprises an infinite loop.

4962. The software procedure of aspect 4955, wherein the software procedure is a written in a modified version of an existing computer language.

4963. The software procedure of aspect 4962 wherein the existing computer language is one of C, C+, C++, Java, Basic, Pascal, and Fortran.

4964. The software procedure of aspect 4955 wherein the software procedure is written in a computer language wherein each operator of a set consisting of all operators in the computer language has unambiguous semantics and is incapable of an invoking infinite code path alone or in combination with other operators.

4965. The software procedure of aspect 4955 wherein the software procedure is written in a computer language wherein all procedures created in the language have a decidable and complete data flow.

4966. The software procedure of aspect 4955 wherein the software procedure is written in a computer language wherein a FIOSM can be generated for any procedure created in the language.

4967. The software procedure of aspect 4955 wherein the software procedure is written in a computer language wherein the software procedure is written in a computer language wherein each operator of a set consisting of all operators in the computer language is incapable of an invoking infinite code path alone or in combination with other operators.

4968. A software procedure comprising at least 1,000 lines of code wherein a finite input output model (FIOSM) can be generated for the software procedure.

4969. The software procedure of aspect 4968, wherein the software procedure does not include operators having ambiguous semantics or operators capable of invoking infinite code paths.

4970. The software procedure of aspect 4969, wherein the infinite code paths comprise infinite loops.

4971. The software procedure of aspect 4968, further including a plurality of operators wherein not one of the plurality of operators is capable of invoking an infinite code path in the software procedure.

4972. The software procedure of aspect 4971, wherein the infinite code path comprises an infinite loop.

4973. The software procedure of aspect 4968, further including a plurality of operators wherein no combination of operators of the plurality of operators are capable of invoking an infinite code path in the software procedure.

4974. The software procedure of aspect 4973, wherein the infinite code path comprises an infinite loop.

4975. The software procedure of aspect 4968, wherein the software procedure is a written in a modified version of an existing computer language.

4976. The software procedure of aspect 4975 wherein the existing computer language is one of C, C+, C++, Java, Basic, Pascal, and Fortran.

4977. The software procedure of aspect 4968 wherein the software procedure is written in a computer language wherein each operator of a set consisting of all operators in the computer language has unambiguous semantics and is incapable of an invoking infinite code path alone or in combination with other operators.

4978. The software procedure of aspect 4968 wherein the software procedure is written in a computer language wherein all procedures created in the language have a decidable and complete data flow.

4979. The software procedure of aspect 4968 wherein the software procedure is written in a computer language wherein a FIOSM can be generated for any procedure created in the language.

4980. The software procedure of aspect 4968 wherein the software procedure is written in a computer language wherein the software procedure is written in a computer language wherein each operator of a set consisting of all operators in the computer language is incapable of an invoking infinite code path alone or in combination with other operators.

4981. A software procedure comprising at least 10,000 lines of code wherein a finite input output model (FIOSM) can be generated for the software procedure.

4982. The software procedure of aspect 4981, wherein the software procedure does not include operators having ambiguous semantics or operators capable of invoking infinite code paths.

4983. The software procedure of aspect 4982, wherein the infinite code paths comprise infinite loops.

4984. The software procedure of aspect 4981, further including a plurality of operators wherein not one of the plurality of operators is capable of invoking an infinite code path in the software procedure.

4985. The software procedure of aspect 4984, wherein the infinite code path comprises an infinite loop.

4986. The software procedure of aspect 4981, further including a plurality of operators wherein no combination of operators of the plurality of operators are capable of invoking an infinite code path in the software procedure.

4987. The software procedure of aspect 4986, wherein the infinite code path comprises an infinite loop.

4988. The software procedure of aspect 4981, wherein the software procedure is a written in a modified version of an existing computer language.

4989. The software procedure of aspect 4988 wherein the existing computer language is one of C, C+, C++, Java, Basic, Pascal, and Fortran.

4990. The software procedure of aspect 4981 wherein the software procedure is written in a computer language wherein each operator of a set consisting of all operators in the computer language has unambiguous semantics and is incapable of an invoking infinite code path alone or in combination with other operators.

4991. The software procedure of aspect 4981 wherein the software procedure is written in a computer language wherein all procedures created in the language have a decidable and complete data flow.

4992. The software procedure of aspect 4981 wherein the software procedure is written in a computer language wherein a FIOSM can be generated for any procedure created in the language.

4993. The software procedure of aspect 4981 wherein the software procedure is written in a computer language wherein the software procedure is written in a computer language wherein each operator of a set consisting of all operators in the computer language is incapable of an invoking infinite code path alone or in combination with other operators.

4994. A software procedure comprising at least 100,000 lines of code wherein a finite input output model (FIOSM) can be generated for the software procedure.

4995. The software procedure of aspect 4994, wherein the software procedure does not include operators having ambiguous semantics or operators capable of invoking infinite code paths.

4996. The software procedure of aspect 4995, wherein the infinite code paths comprise infinite loops.

4997. The software procedure of aspect 4994, further including a plurality of operators wherein not one of the plurality of operators is capable of invoking an infinite code path in the software procedure.

4998. The software procedure of aspect 4997, wherein the infinite code path comprises an infinite loop.

4999. The software procedure of aspect 4994, further including a plurality of operators wherein no combination of operators of the plurality of operators are capable of invoking an infinite code path in the software procedure.

5000. The software procedure of aspect 4999, wherein the infinite code path comprises an infinite loop.

5001. The software procedure of aspect 4994, wherein the software procedure is a written in a modified version of an existing computer language.

5002. The software procedure of aspect 5001 wherein the existing computer language is one of C, C+, C++, Java, Basic, Pascal, and Fortran.

5003. The software procedure of aspect 4994 wherein the software procedure is written in a computer language wherein each operator of a set consisting of all operators in the computer language has unambiguous semantics and is incapable of an invoking infinite code path alone or in combination with other operators.

5004. The software procedure of aspect 4994 wherein the software procedure is written in a computer language wherein all procedures created in the language have a decidable and complete data flow.

5005. The software procedure of aspect 4994 wherein the software procedure is written in a computer language wherein a FIOSM can be generated for any procedure created in the language.

5006. The software procedure of aspect 4994 wherein the software procedure is written in a computer language wherein the software procedure is written in a computer language wherein each operator of a set consisting of all operators in the computer language is incapable of an invoking infinite code path alone or in combination with other operators.

5007. A software procedure comprising at least 1,000,000 lines of code wherein a finite input output model (FIOSM) can be generated for the software procedure.

5008. The software procedure of aspect 5007, wherein the software procedure does not include operators having ambiguous semantics or operators capable of invoking infinite code paths.

5009. The software procedure of aspect 5008, wherein the infinite code paths comprise infinite loops.

5010. The software procedure of aspect 5007, further including a plurality of operators wherein not one of the plurality of operators is capable of invoking an infinite code path in the software procedure.

5011. The software procedure of aspect 5010, wherein the infinite code path comprises an infinite loop.

5012. The software procedure of aspect 5007, further including a plurality of operators wherein no combination of operators of the plurality of operators are capable of invoking an infinite code path in the software procedure.

5013. The software procedure of aspect 5012, wherein the infinite code path comprises an infinite loop.

5014. The software procedure of aspect 5007, wherein the software procedure is a written in a modified version of an existing computer language.

5015. The software procedure of aspect 5014 wherein the existing computer language is one of C, C+, C++, Java, Basic, Pascal, and Fortran.

5016. The software procedure of aspect 5007 wherein the software procedure is written in a computer language wherein each operator of a set consisting of all operators in the computer language has unambiguous semantics and is incapable of an invoking infinite code path alone or in combination with other operators.

5017. The software procedure of aspect 5007 wherein the software procedure is written in a computer language wherein all procedures created in the language have a decidable and complete data flow.

5018. The software procedure of aspect 5007 wherein the software procedure is written in a computer language wherein a FIOSM can be generated for any procedure created in the language.

5019. The software procedure of aspect 5007 wherein the software procedure is written in a computer language wherein the software procedure is written in a computer language wherein each operator of a set consisting of all operators in the computer language is incapable of an invoking infinite code path alone or in combination with other operators.

5020. A computer program governed by a finite input/output semantic (FIOSM) model.

5021. The computer program of aspect 5020, wherein the computer program does not include operators having ambiguous semantics or operators capable of invoking infinite code paths.

5022. The computer program of aspect 5021, wherein the infinite code paths comprise infinite loops.

5023. The computer program of aspect 5020, further including a plurality of operators wherein not one of the plurality of operators is capable of invoking an infinite code path in the computer program.

5024. The computer program of aspect 5023, wherein the infinite code path comprises an infinite loop.

5025. The computer program of aspect 5020, further including a plurality of operators wherein no combination of operators of the plurality of operators are capable of invoking an infinite code path in the computer program.

5026. The computer program of aspect 5025, wherein the infinite code path comprises an infinite loop.

5027. The computer program of aspect 5020, wherein the computer program is a written in a modified version of a preexisting computer language, the modified version having a decidable and complete data flow.

5028. The computer program of aspect 5027 wherein the existing computer language is one of C, C+, C++, Java, Basic, Pascal, and Fortran.

5029. The computer program of aspect 5020 wherein the computer program is written in a computer language wherein each operator of a set consisting of all operators in the computer language has unambiguous semantics and is incapable of an invoking infinite code path alone or in combination with other operators.

5030. The computer program of aspect 5020 wherein the computer program is written in a computer language wherein all programs created in the language have a decidable and complete data flow.

5031. The computer program of aspect 5020 wherein the computer program is written in a computer language wherein a finite input output semantic model can be generated for any program created in the language.

5032. The computer program of aspect 5020 wherein the computer program is written in a computer language wherein the computer program is written in a computer language wherein each operator of a set consisting of all operators in the computer language is incapable of an invoking infinite code path alone or in combination with other operators.

5033. The computer program of aspect 5020, comprising at least 1,000 lines of code.

5034. The computer program of aspect 5021, comprising at least 1,000 lines of code.

5035. The computer program of aspect 5022, comprising at least 1,000 lines of code.

5036. The computer program of aspect 5023, comprising at least 1,000 lines of code.

5037. The computer program of aspect 5024, comprising at least 1,000 lines of code.

5038. The computer program of aspect 5025, comprising at least 1,000 lines of code.

5039. The computer program of aspect 5026, comprising at least 1,000 lines of code.

5040. The computer program of aspect 5027, comprising at least 1,000 lines of code.

5041. The computer program of aspect 5028, comprising at least 1,000 lines of code.

5042. The computer program of aspect 5029, comprising at least 1,000 lines of code.

5043. The computer program of aspect 5030, comprising at least 1,000 lines of code.

5044. The computer program of aspect 5031, comprising at least 1,000 lines of code.

5045. The computer program of aspect 5032, comprising at least 1,000 lines of code.

5046. The computer program of aspect 5020, comprising at least 10,000 lines of code.

5047. The computer program of aspect 5021, comprising at least 10,000 lines of code.

5048. The computer program of aspect 5022, comprising at least 10,000 lines of code.

5049. The computer program of aspect 5023, comprising at least 10,000 lines of code.

5050. The computer program of aspect 5024, comprising at least 10,000 lines of code.

5051. The computer program of aspect 5025, comprising at least 10,000 lines of code.

5052. The computer program of aspect 5026, comprising at least 10,000 lines of code.

5053. The computer program of aspect 5027, comprising at least 10,000 lines of code.

5054. The computer program of aspect 5028, comprising at least 10,000 lines of code.

5055. The computer program of aspect 5029, comprising at least 10,000 lines of code.

5056. The computer program of aspect 5030, comprising at least 10,000 lines of code.

5057. The computer program of aspect 5031, comprising at least 10,000 lines of code.

5058. The computer program of aspect 5032, comprising at least 10,000 lines of code.

5059. The computer program of aspect 5020, comprising at least 100,000 lines of code.

5060. The computer program of aspect 5021, comprising at least 100,000 lines of code.

5061. The computer program of aspect 5022, comprising at least 100,000 lines of code.

5062. The computer program of aspect 5023, comprising at least 100,000 lines of code.

5063. The computer program of aspect 5024, comprising at least 100,000 lines of code.

5064. The computer program of aspect 5025, comprising at least 100,000 lines of code.

5065. The computer program of aspect 5026, comprising at least 100,000 lines of code.

5066. The computer program of aspect 5027, comprising at least 100,000 lines of code.

5067. The computer program of aspect 5028, comprising at least 100,000 lines of code.

5068. The computer program of aspect 5029, comprising at least 100,000 lines of code.

5069. The computer program of aspect 5030, comprising at least 100,000 lines of code.

5070. The computer program of aspect 5031, comprising at least 100,000 lines of code.

5071. The computer program of aspect 5032, comprising at least 100,000 lines of code.

5072. The computer program of aspect 5020, comprising at least 1,000,000 lines of code.

5073. The computer program of aspect 5021, comprising at least 1,000,000 lines of code.

5074. The computer program of aspect 5022, comprising at least 1,000,000 lines of code.

5075. The computer program of aspect 5023, comprising at least 1,000,000 lines of code.

5076. The computer program of aspect 5024, comprising at least 1,000,000 lines of code.

5077. The computer program of aspect 5025, comprising at least 1,000,000 lines of code.

5078. The computer program of aspect 5026, comprising at least 1,000,000 lines of code.

5079. The computer program of aspect 5027, comprising at least 1,000,000 lines of code.

5080. The computer program of aspect 5028, comprising at least 1,000,000 lines of code.

5081. The computer program of aspect 5029, comprising at least 1,000,000 lines of code.

5082. The computer program of aspect 5030, comprising at least 1,000,000 lines of code.

5083. The computer program of aspect 5031, comprising at least 1,000,000 lines of code.

5084. The computer program of aspect 5032, comprising at least 1,000,000 lines of code.

5085. A computer program wherein all outputs can be mapped to all inputs.

5086. The computer program of aspect 5085, wherein the computer program does not include operators having ambiguous semantics or operators capable of invoking infinite code paths.

5087. The computer program of aspect 5086, wherein the infinite code paths comprise infinite loops.

5088. The computer program of aspect 5085, further including a plurality of operators wherein not one of the plurality of operators is capable of invoking an infinite code path in the computer program.

5089. The computer program of aspect 5088, wherein the infinite code path comprises an infinite loop.

5090. The computer program of aspect 5085, further including a plurality of operators wherein no combination of operators of the plurality of operators are capable of invoking an infinite code path in the computer program.

5091. The computer program of aspect 5090, wherein the infinite code path comprises an infinite loop.

5092. The computer program of aspect 5085, wherein the computer program is a written in a modified version of an existing computer language.

5093. The computer program of aspect 5092 wherein the existing computer language is one of C, C+, C++, Java, Basic, Pascal, and Fortran.

5094. The computer program of aspect 5085 wherein the computer program is written in a computer language wherein each operator of a set consisting of all operators in the computer language has unambiguous semantics and is incapable of an invoking infinite code path alone or in combination with other operators.

5095. The computer program of aspect 5085 wherein the computer program is written in a computer language wherein all programs created in the language have a decidable and complete data flow.

5096. The computer program of aspect 5085 wherein the computer program is written in a computer language wherein a finite input output semantic model can be generated for any program created in the language.

5097. The computer program of aspect 5085 wherein the computer program is written in a computer language wherein the computer program is written in a computer language wherein each operator of a set consisting of all operators in the computer language is incapable of an invoking infinite code path alone or in combination with other operators.

5098. The computer program of aspect 5085, comprising at least 1,000 lines of code.

5099. The computer program of aspect 5086, comprising at least 1,000 lines of code.

5100. The computer program of aspect 5087, comprising at least 1,000 lines of code.

5101. The computer program of aspect 5088, comprising at least 1,000 lines of code.

5102. The computer program of aspect 5089, comprising at least 1,000 lines of code.

5103. The computer program of aspect 5090, comprising at least 1,000 lines of code.

5104. The computer program of aspect 5091, comprising at least 1,000 lines of code.

5105. The computer program of aspect 5092, comprising at least 1,000 lines of code.

5106. The computer program of aspect 5093, comprising at least 1,000 lines of code.

5107. The computer program of aspect 5094, comprising at least 1,000 lines of code.

5108. The computer program of aspect 5095, comprising at least 1,000 lines of code.

5109. The computer program of aspect 5096, comprising at least 1,000 lines of code.

5110. The computer program of aspect 5097, comprising at least 1,000 lines of code.

5111. The computer program of aspect 5085, comprising at least 10,000 lines of code.

5112. The computer program of aspect 5086, comprising at least 10,000 lines of code.

5113. The computer program of aspect 5087, comprising at least 10,000 lines of code.

5114. The computer program of aspect 5088, comprising at least 10,000 lines of code.

5115. The computer program of aspect 5089, comprising at least 10,000 lines of code.

5116. The computer program of aspect 5090, comprising at least 10,000 lines of code.

5117. The computer program of aspect 5091, comprising at least 10,000 lines of code.

5118. The computer program of aspect 5092, comprising at least 10,000 lines of code.

5119. The computer program of aspect 5093, comprising at least 10,000 lines of code.

5120. The computer program of aspect 5094, comprising at least 10,000 lines of code.

5121. The computer program of aspect 5095, comprising at least 10,000 lines of code.

5122. The computer program of aspect 5096, comprising at least 10,000 lines of code.

5123. The computer program of aspect 5097, comprising at least 10,000 lines of code.

5124. The computer program of aspect 5085, comprising at least 100,000 lines of code.

5125. The computer program of aspect 5086, comprising at least 100,000 lines of code.

5126. The computer program of aspect 5087, comprising at least 100,000 lines of code.

5127. The computer program of aspect 5088, comprising at least 100,000 lines of code.

5128. The computer program of aspect 5089, comprising at least 100,000 lines of code.

5129. The computer program of aspect 5090, comprising at least 100,000 lines of code.

5130. The computer program of aspect 5091, comprising at least 100,000 lines of code.

5131. The computer program of aspect 5092, comprising at least 100,000 lines of code.

5132. The computer program of aspect 5093, comprising at least 100,000 lines of code.

5133. The computer program of aspect 5094, comprising at least 100,000 lines of code.

5134. The computer program of aspect 5095, comprising at least 100,000 lines of code.

5135. The computer program of aspect 5096, comprising at least 100,000 lines of code.

5136. The computer program of aspect 5097, comprising at least 100,000 lines of code.

5137. The computer program of aspect 5085, comprising at least 1,000,000 lines of code.

5138. The computer program of aspect 5086, comprising at least 1,000,000 lines of code.

5139. The computer program of aspect 5087, comprising at least 1,000,000 lines of code.

5140. The computer program of aspect 5088, comprising at least 1,000,000 lines of code.

5141. The computer program of aspect 5089, comprising at least 1,000,000 lines of code.

5142. The computer program of aspect 5090, comprising at least 1,000,000 lines of code.

5143. The computer program of aspect 5091, comprising at least 1,000,000 lines of code.

5144. The computer program of aspect 5092, comprising at least 1,000,000 lines of code.

5145. The computer program of aspect 5093, comprising at least 1,000,000 lines of code.

5146. The computer program of aspect 5094, comprising at least 1,000,000 lines of code.

5147. The computer program of aspect 5095, comprising at least 1,000,000 lines of code.

5148. The computer program of aspect 5096, comprising at least 1,000,000 lines of code.

5149. The computer program of aspect 5097, comprising at least 1,000,000 lines of code.

5150. A computer program having a finite set of input and output patterns.

5151. The computer program of aspect 5150, wherein the computer program does not include operators having ambiguous semantics or operators capable of invoking infinite code paths.

5152. The computer program of aspect 5151, wherein the infinite code paths comprise infinite loops.

5153. The computer program of aspect 5150, further including a plurality of operators wherein not one of the plurality of operators is capable of invoking an infinite code path in the computer program.

5154. The computer program of aspect 5153, wherein the infinite code path comprises an infinite loop.

5155. The computer program of aspect 5150, further including a plurality of operators wherein no combination of operators of the plurality of operators are capable of invoking an infinite code path in the computer program.

5156. The computer program of aspect 5155, wherein the infinite code path comprises an infinite loop.

5157. The computer program of aspect 5150, wherein the computer program is a written in a modified version of an existing computer language.

5158. The computer program of aspect 5157 wherein the existing computer language is one of C, C+, C++, Java, Basic, Pascal, and Fortran.

5159. The computer program of aspect 5150 wherein the computer program is written in a computer language wherein each operator of a set consisting of all operators in the computer language has unambiguous semantics and is incapable of an invoking infinite code path alone or in combination with other operators.

5160. The computer program of aspect 5150 wherein the computer program is written in a computer language wherein all programs created in the language have a decidable and complete data flow.

5161. The computer program of aspect 5150 wherein the computer program is written in a computer language wherein a finite input output semantic model can be generated for any program created in the language.

5162. The computer program of aspect 5150 wherein the computer program is written in a computer language wherein the computer program is written in a computer language wherein each operator of a set consisting of all operators in the computer language is incapable of an invoking infinite code path alone or in combination with other operators.

5163. The computer program of aspect 5150, comprising at least 1,000 lines of code.

5164. The computer program of aspect 5151, comprising at least 1,000 lines of code.

5165. The computer program of aspect 5152, comprising at least 1,000 lines of code.

5166. The computer program of aspect 5153, comprising at least 1,000 lines of code.

5167. The computer program of aspect 5154, comprising at least 1,000 lines of code.

5168. The computer program of aspect 5155, comprising at least 1,000 lines of code.

5169. The computer program of aspect 5156, comprising at least 1,000 lines of code.

5170. The computer program of aspect 5157, comprising at least 1,000 lines of code.

5171. The computer program of aspect 5158, comprising at least 1,000 lines of code.

5172. The computer program of aspect 5159, comprising at least 1,000 lines of code.

5173. The computer program of aspect 5160, comprising at least 1,000 lines of code.

5174. The computer program of aspect 5161, comprising at least 1,000 lines of code.

5175. The computer program of aspect 5162, comprising at least 1,000 lines of code.

5176. The computer program of aspect 5150, comprising at least 10,000 lines of code.

5177. The computer program of aspect 5151, comprising at least 10,000 lines of code.

5178. The computer program of aspect 5152, comprising at least 10,000 lines of code.

5179. The computer program of aspect 5153, comprising at least 10,000 lines of code.

5180. The computer program of aspect 5154, comprising at least 10,000 lines of code.

5181. The computer program of aspect 5155, comprising at least 10,000 lines of code.

5182. The computer program of aspect 5156, comprising at least 10,000 lines of code.

5183. The computer program of aspect 5157, comprising at least 10,000 lines of code.

5184. The computer program of aspect 5158, comprising at least 10,000 lines of code.

5185. The computer program of aspect 5159, comprising at least 10,000 lines of code.

5186. The computer program of aspect 5160, comprising at least 10,000 lines of code.

5187. The computer program of aspect 5161, comprising at least 10,000 lines of code.

5188. The computer program of aspect 5162, comprising at least 10,000 lines of code.

5189. The computer program of aspect 5150, comprising at least 100,000 lines of code.

5190. The computer program of aspect 5151, comprising at least 100,000 lines of code.

5191. The computer program of aspect 5152, comprising at least 100,000 lines of code.

5192. The computer program of aspect 5153, comprising at least 100,000 lines of code.

5193. The computer program of aspect 5154, comprising at least 100,000 lines of code.

5194. The computer program of aspect 5155, comprising at least 100,000 lines of code.

5195. The computer program of aspect 5156, comprising at least 100,000 lines of code.

5196. The computer program of aspect 5157, comprising at least 100,000 lines of code.

5197. The computer program of aspect 5158, comprising at least 100,000 lines of code.

5198. The computer program of aspect 5159, comprising at least 100,000 lines of code.

5199. The computer program of aspect 5160, comprising at least 100,000 lines of code.

5200. The computer program of aspect 5161, comprising at least 100,000 lines of code.

5201. The computer program of aspect 5162, comprising at least 100,000 lines of code.

5202. The computer program of aspect 5150, comprising at least 1,000,000 lines of code.

5203. The computer program of aspect 5151, comprising at least 1,000,000 lines of code.

5204. The computer program of aspect 5152, comprising at least 1,000,000 lines of code.

5205. The computer program of aspect 5153, comprising at least 1,000,000 lines of code.

5206. The computer program of aspect 5154, comprising at least 1,000,000 lines of code.

5207. The computer program of aspect 5155, comprising at least 1,000,000 lines of code.

5208. The computer program of aspect 5156, comprising at least 1,000,000 lines of code.

5209. The computer program of aspect 5157, comprising at least 1,000,000 lines of code.

5210. The computer program of aspect 5158, comprising at least 1,000,000 lines of code.

5211. The computer program of aspect 5159, comprising at least 1,000,000 lines of code.

5212. The computer program of aspect 5160, comprising at least 1,000,000 lines of code.

5213. The computer program of aspect 5161, comprising at least 1,000,000 lines of code.

5214. The computer program of aspect 5162, comprising at least 1,000,000 lines of code.

5215. A computer program having completely decidable data flow.

5216. The computer program of aspect 5215, wherein the computer program does not include operators having ambiguous semantics or operators capable of invoking infinite code paths.

5217. The computer program of aspect 5216, wherein the infinite code paths comprise infinite loops.

5218. The computer program of aspect 5215, further including a plurality of operators wherein not one of the plurality of operators is capable of invoking an infinite code path in the computer program.

5219. The computer program of aspect 5218, wherein the infinite code path comprises an infinite loop.

5220. The computer program of aspect 5215, further including a plurality of operators wherein no combination of operators of the plurality of operators are capable of invoking an infinite code path in the computer program.

5221. The computer program of aspect 5220, wherein the infinite code path comprises an infinite loop.

5222. The computer program of aspect 5215, wherein the computer program is a written in a modified version of an existing computer language.

5223. The computer program of aspect 5222 wherein the existing computer language is one of C, C+, C++, Java, Basic, Pascal, and Fortran.

5224. The computer program of aspect 5215 wherein the computer program is written in a computer language wherein each operator of a set consisting of all operators in the computer language has unambiguous semantics and is incapable of an invoking infinite code path alone or in combination with other operators.

5225. The computer program of aspect 5215 wherein the computer program is written in a computer language wherein all programs created in the language have a decidable and complete data flow.

5226. The computer program of aspect 5215 wherein the computer program is written in a computer language wherein a finite input output semantic model can be generated for any program created in the language.

5227. The computer program of aspect 5215 wherein the computer program is written in a computer language wherein the computer program is written in a computer language wherein each operator of a set consisting of all operators in the computer language is incapable of an invoking infinite code path alone or in combination with other operators.

5228. The computer program of aspect 5215, comprising at least 1,000 lines of code.

5229. The computer program of aspect 5216, comprising at least 1,000 lines of code.

5230. The computer program of aspect 5217, comprising at least 1,000 lines of code.

5231. The computer program of aspect 5218, comprising at least 1,000 lines of code.

5232. The computer program of aspect 5219, comprising at least 1,000 lines of code.

5233. The computer program of aspect 5220, comprising at least 1,000 lines of code.

5234. The computer program of aspect 5221, comprising at least 1,000 lines of code.

5235. The computer program of aspect 5222, comprising at least 1,000 lines of code.

5236. The computer program of aspect 5223, comprising at least 1,000 lines of code.

5237. The computer program of aspect 5224, comprising at least 1,000 lines of code.

5238. The computer program of aspect 5225, comprising at least 1,000 lines of code.

5239. The computer program of aspect 5226, comprising at least 1,000 lines of code.

5240. The computer program of aspect 5227, comprising at least 1,000 lines of code.

5241. The computer program of aspect 5215, comprising at least 10,000 lines of code.

5242. The computer program of aspect 5216, comprising at least 10,000 lines of code.

5243. The computer program of aspect 5217, comprising at least 10,000 lines of code.

5244. The computer program of aspect 5218, comprising at least 10,000 lines of code.

5245. The computer program of aspect 5219, comprising at least 10,000 lines of code.

5246. The computer program of aspect 5220, comprising at least 10,000 lines of code.

5247. The computer program of aspect 5221, comprising at least 10,000 lines of code.

5248. The computer program of aspect 5222, comprising at least 10,000 lines of code.

5249. The computer program of aspect 5223, comprising at least 10,000 lines of code.

5250. The computer program of aspect 5224, comprising at least 10,000 lines of code.

5251. The computer program of aspect 5225, comprising at least 10,000 lines of code.

5252. The computer program of aspect 5226, comprising at least 10,000 lines of code.

5253. The computer program of aspect 5227, comprising at least 10,000 lines of code.

5254. The computer program of aspect 5215, comprising at least 100,000 lines of code.

5255. The computer program of aspect 5216, comprising at least 100,000 lines of code.

5256. The computer program of aspect 5217, comprising at least 100,000 lines of code.

5257. The computer program of aspect 5218, comprising at least 100,000 lines of code.

5258. The computer program of aspect 5219, comprising at least 100,000 lines of code.

5259. The computer program of aspect 5220, comprising at least 100,000 lines of code.

5260. The computer program of aspect 5221, comprising at least 100,000 lines of code.

5261. The computer program of aspect 5222, comprising at least 100,000 lines of code.

5262. The computer program of aspect 5223, comprising at least 100,000 lines of code.

5263. The computer program of aspect 5224, comprising at least 100,000 lines of code.

5264. The computer program of aspect 5225, comprising at least 100,000 lines of code.

5265. The computer program of aspect 5226, comprising at least 100,000 lines of code.

5266. The computer program of aspect 5227, comprising at least 100,000 lines of code.

5267. The computer program of aspect 5215, comprising at least 1,000,000 lines of code.

5268. The computer program of aspect 5216, comprising at least 1,000,000 lines of code.

5269. The computer program of aspect 5217, comprising at least 1,000,000 lines of code.

5270. The computer program of aspect 5218, comprising at least 1,000,000 lines of code.

5271. The computer program of aspect 5219, comprising at least 1,000,000 lines of code.

5272. The computer program of aspect 5220, comprising at least 1,000,000 lines of code.

5273. The computer program of aspect 5221, comprising at least 1,000,000 lines of code.

5274. The computer program of aspect 5222, comprising at least 1,000,000 lines of code.

5275. The computer program of aspect 5223, comprising at least 1,000,000 lines of code.

5276. The computer program of aspect 5224, comprising at least 1,000,000 lines of code.

5277. The computer program of aspect 5225, comprising at least 1,000,000 lines of code.

5278. The computer program of aspect 5226, comprising at least 1,000,000 lines of code.

5279. The computer program of aspect 5227, comprising at least 1,000,000 lines of code.

5280. A software program embodying the finite code path property.

5281. The computer program of aspect 5280, wherein the computer program does not include operators having ambiguous semantics or operators capable of invoking infinite code paths.

5282. The computer program of aspect 5281, wherein the infinite code paths comprise infinite loops.

5283. The computer program of aspect 5280, further including a plurality of operators wherein not one of the plurality of operators is capable of invoking an infinite code path in the computer program.

5284. The computer program of aspect 5283, wherein the infinite code path comprises an infinite loop.

5285. The computer program of aspect 5280, further including a plurality of operators wherein no combination of operators of the plurality of operators are capable of invoking an infinite code path in the computer program.

5286. The computer program of aspect 5285, wherein the infinite code path comprises an infinite loop.

5287. The computer program of aspect 5280, wherein the computer program is a written in a modified version of an existing computer language.

5288. The computer program of aspect 5287 wherein the existing computer language is one of C, C+, C++, Java, Basic, Pascal, and Fortran.

5289. The computer program of aspect 5280 wherein the computer program is written in a computer language wherein each operator of a set consisting of all operators in the computer language has unambiguous semantics and is incapable of an invoking infinite code path alone or in combination with other operators.

5290. The computer program of aspect 5280 wherein the computer program is written in a computer language wherein all programs created in the language have a decidable and complete data flow.

5291. The computer program of aspect 5280 wherein the computer program is written in a computer language wherein a finite input output semantic model can be generated for any program created in the language.

5292. The computer program of aspect 5280 wherein the computer program is written in a computer language wherein the computer program is written in a computer language wherein each operator of a set consisting of all operators in the computer language is incapable of an invoking infinite code path alone or in combination with other operators.

5293. The computer program of aspect 5280, comprising at least 1,000 lines of code.

5294. The computer program of aspect 5281, comprising at least 1,000 lines of code.

5295. The computer program of aspect 5282, comprising at least 1,000 lines of code.

5296. The computer program of aspect 5283, comprising at least 1,000 lines of code.

5297. The computer program of aspect 5284, comprising at least 1,000 lines of code.

5298. The computer program of aspect 5285, comprising at least 1,000 lines of code.

5299. The computer program of aspect 5286, comprising at least 1,000 lines of code.

5300. The computer program of aspect 5287, comprising at least 1,000 lines of code.

5301. The computer program of aspect 5288, comprising at least 1,000 lines of code.

5302. The computer program of aspect 5289, comprising at least 1,000 lines of code.

5303. The computer program of aspect 5290, comprising at least 1,000 lines of code.

5304. The computer program of aspect 5291, comprising at least 1,000 lines of code.

5305. The computer program of aspect 5292, comprising at least 1,000 lines of code.

5306. The computer program of aspect 5280, comprising at least 10,000 lines of code.

5307. The computer program of aspect 5281, comprising at least 10,000 lines of code.

5308. The computer program of aspect 5282, comprising at least 10,000 lines of code.

5309. The computer program of aspect 5283, comprising at least 10,000 lines of code.

5310. The computer program of aspect 5284, comprising at least 10,000 lines of code.

5311. The computer program of aspect 5285, comprising at least 10,000 lines of code.

5312. The computer program of aspect 5286, comprising at least 10,000 lines of code.

5313. The computer program of aspect 5287, comprising at least 10,000 lines of code.

5314. The computer program of aspect 5288, comprising at least 10,000 lines of code.

5315. The computer program of aspect 5289, comprising at least 10,000 lines of code.

5316. The computer program of aspect 5290, comprising at least 10,000 lines of code.

5317. The computer program of aspect 5291, comprising at least 10,000 lines of code.

5318. The computer program of aspect 5292, comprising at least 10,000 lines of code.

5319. The computer program of aspect 5280, comprising at least 100,000 lines of code.

5320. The computer program of aspect 5281, comprising at least 100,000 lines of code.

5321. The computer program of aspect 5282, comprising at least 100,000 lines of code.

5322. The computer program of aspect 5283, comprising at least 100,000 lines of code.

5323. The computer program of aspect 5284, comprising at least 100,000 lines of code.

5324. The computer program of aspect 5285, comprising at least 100,000 lines of code.

5325. The computer program of aspect 5286, comprising at least 100,000 lines of code.

5326. The computer program of aspect 5287, comprising at least 100,000 lines of code.

5327. The computer program of aspect 5288, comprising at least 100,000 lines of code.

5328. The computer program of aspect 5289, comprising at least 100,000 lines of code.

5329. The computer program of aspect 5290, comprising at least 100,000 lines of code.

5330. The computer program of aspect 5291, comprising at least 100,000 lines of code.

5331. The computer program of aspect 5292, comprising at least 100,000 lines of code.

5332. The computer program of aspect 5280, comprising at least 1,000,000 lines of code.

5333. The computer program of aspect 5281, comprising at least 1,000,000 lines of code.

5334. The computer program of aspect 5282, comprising at least 1,000,000 lines of code.

5335. The computer program of aspect 5283, comprising at least 1,000,000 lines of code.

5336. The computer program of aspect 5284, comprising at least 1,000,000 lines of code.

5337. The computer program of aspect 5285, comprising at least 1,000,000 lines of code.

5338. The computer program of aspect 5286, comprising at least 1,000,000 lines of code.

5339. The computer program of aspect 5287, comprising at least 1,000,000 lines of code.

5340. The computer program of aspect 5288, comprising at least 1,000,000 lines of code.

5341. The computer program of aspect 5289, comprising at least 1,000,000 lines of code.

5342. The computer program of aspect 5290, comprising at least 1,000,000 lines of code.

5343. The computer program of aspect 5291, comprising at least 1,000,000 lines of code.

5344. The computer program of aspect 5292, comprising at least 1,000,000 lines of code.

5345. A computer program compatible with a finite input output model (FIOSM).

5346. The computer program of aspect 5345, wherein the computer program does not include operators having ambiguous semantics or operators capable of invoking infinite code paths.

5347. The computer program of aspect 5346, wherein the infinite code paths comprise infinite loops.

5348. The computer program of aspect 5345, further including a plurality of operators wherein not one of the plurality of operators is capable of invoking an infinite code path in the computer program.

5349. The computer program of aspect 5348, wherein the infinite code path comprises an infinite loop.

5350. The computer program of aspect 5345, further including a plurality of operators wherein no combination of operators of the plurality of operators are capable of invoking an infinite code path in the computer program.

5351. The computer program of aspect 5350, wherein the infinite code path comprises an infinite loop.

5352. The computer program of aspect 5345, wherein the computer program is a written in a modified version of an existing computer language.

5353. The computer program of aspect 5352 wherein the existing computer language is one of C, C+, C++, Java, Basic, Pascal, and Fortran.

5354. The computer program of aspect 5345 wherein the computer program is written in a computer language wherein each operator of a set consisting of all operators in the computer language has unambiguous semantics and is incapable of an invoking infinite code path alone or in combination with other operators.

5355. The computer program of aspect 5345 wherein the computer program is written in a computer language wherein all programs created in the language have a decidable and complete data flow.

5356. The computer program of aspect 5345 wherein the computer program is written in a computer language wherein a finite input output semantic model can be generated for any program created in the language.

5357. The computer program of aspect 5345 wherein the computer program is written in a computer language wherein the computer program is written in a computer language wherein each operator of a set consisting of all operators in the computer language is incapable of an invoking infinite code path alone or in combination with other operators.

5358. The computer program of aspect 5345, comprising at least 1,000 lines of code.

5359. The computer program of aspect 5346, comprising at least 1,000 lines of code.

5360. The computer program of aspect 5347, comprising at least 1,000 lines of code.

5361. The computer program of aspect 5348, comprising at least 1,000 lines of code.

5362. The computer program of aspect 5349, comprising at least 1,000 lines of code.

5363. The computer program of aspect 5350, comprising at least 1,000 lines of code.

5364. The computer program of aspect 5351, comprising at least 1,000 lines of code.

5365. The computer program of aspect 5352, comprising at least 1,000 lines of code.

5366. The computer program of aspect 5353, comprising at least 1,000 lines of code.

5367. The computer program of aspect 5354, comprising at least 1,000 lines of code.

5368. The computer program of aspect 5355, comprising at least 1,000 lines of code.

5369. The computer program of aspect 5356, comprising at least 1,000 lines of code.

5370. The computer program of aspect 5357, comprising at least 1,000 lines of code.

5371. The computer program of aspect 5345, comprising at least 10,000 lines of code.

5372. The computer program of aspect 5346, comprising at least 10,000 lines of code.

5373. The computer program of aspect 5347, comprising at least 10,000 lines of code.

5374. The computer program of aspect 5348, comprising at least 10,000 lines of code.

5375. The computer program of aspect 5349, comprising at least 10,000 lines of code.

5376. The computer program of aspect 5350, comprising at least 10,000 lines of code.

5377. The computer program of aspect 5351, comprising at least 10,000 lines of code.

5378. The computer program of aspect 5352, comprising at least 10,000 lines of code.

5379. The computer program of aspect 5353, comprising at least 10,000 lines of code.

5380. The computer program of aspect 5354, comprising at least 10,000 lines of code.

5381. The computer program of aspect 5355, comprising at least 10,000 lines of code.

5382. The computer program of aspect 5356, comprising at least 10,000 lines of code.

5383. The computer program of aspect 5357, comprising at least 10,000 lines of code.

5384. The computer program of aspect 5345, comprising at least 100,000 lines of code.

5385. The computer program of aspect 5346, comprising at least 100,000 lines of code.

5386. The computer program of aspect 5347, comprising at least 100,000 lines of code.

5387. The computer program of aspect 5348, comprising at least 100,000 lines of code.

5388. The computer program of aspect 5349, comprising at least 100,000 lines of code.

5389. The computer program of aspect 5350, comprising at least 100,000 lines of code.

5390. The computer program of aspect 5351, comprising at least 100,000 lines of code.

5391. The computer program of aspect 5352, comprising at least 100,000 lines of code.

5392. The computer program of aspect 5353, comprising at least 100,000 lines of code.

5393. The computer program of aspect 5354, comprising at least 100,000 lines of code.

5394. The computer program of aspect 5355, comprising at least 100,000 lines of code.

5395. The computer program of aspect 5356, comprising at least 100,000 lines of code.

5396. The computer program of aspect 5357, comprising at least 100,000 lines of code.

5397. The computer program of aspect 5345, comprising at least 1,000,000 lines of code.

5398. The computer program of aspect 5346, comprising at least 1,000,000 lines of code.

5399. The computer program of aspect 5347, comprising at least 1,000,000 lines of code.

5400. The computer program of aspect 5348, comprising at least 1,000,000 lines of code.

5401. The computer program of aspect 5349, comprising at least 1,000,000 lines of code.

5402. The computer program of aspect 5350, comprising at least 1,000,000 lines of code.

5403. The computer program of aspect 5351, comprising at least 1,000,000 lines of code.

5404. The computer program of aspect 5352, comprising at least 1,000,000 lines of code.

5405. The computer program of aspect 5353, comprising at least 1,000,000 lines of code.

5406. The computer program of aspect 5354, comprising at least 1,000,000 lines of code.

5407. The computer program of aspect 5355, comprising at least 1,000,000 lines of code.

5408. The computer program of aspect 5356, comprising at least 1,000,000 lines of code.

5409. The computer program of aspect 5357, comprising at least 1,000,000 lines of code.

5410. A computer program wherein a finite input output model (FIOSM) can be generated for the program.

5411. The computer program of aspect 5410, wherein the computer program does not include operators having ambiguous semantics or operators capable of invoking infinite code paths.

5412. The computer program of aspect 5411, wherein the infinite code paths comprise infinite loops.

5413. The computer program of aspect 5410, further including a plurality of operators wherein not one of the plurality of operators is capable of invoking an infinite code path in the computer program.

5414. The computer program of aspect 5413, wherein the infinite code path comprises an infinite loop.

5415. The computer program of aspect 5410, further including a plurality of operators wherein no combination of operators of the plurality of operators are capable of invoking an infinite code path in the computer program.

5416. The computer program of aspect 5415, wherein the infinite code path comprises an infinite loop.

5417. The computer program of aspect 5410, wherein the computer program is a written in a modified version of an existing computer language.

5418. The computer program of aspect 5417 wherein the existing computer language is one of C, C+, C++, Java, Basic, Pascal, and Fortran.

5419. The computer program of aspect 5410 wherein the computer program is written in a computer language wherein each operator of a set consisting of all operators in the computer language has unambiguous semantics and is incapable of an invoking infinite code path alone or in combination with other operators.

5420. The computer program of aspect 5410 wherein the computer program is written in a computer language wherein all programs created in the language have a decidable and complete data flow.

5421. The computer program of aspect 5410 wherein the computer program is written in a computer language wherein a FIOSM can be generated for any program created in the language.

5422. The computer program of aspect 5410 wherein the computer program is written in a computer language wherein the computer program is written in a computer language wherein each operator of a set consisting of all operators in the computer language is incapable of an invoking infinite code path alone or in combination with other operators.

5423. A computer program comprising at least 1,000 lines of code wherein a finite input output model (FIOSM) can be generated for the program.

5424. The computer program of aspect 5423, wherein the computer program does not include operators having ambiguous semantics or operators capable of invoking infinite code paths.

5425. The computer program of aspect 5424, wherein the infinite code paths comprise infinite loops.

5426. The computer program of aspect 5423, further including a plurality of operators wherein not one of the plurality of operators is capable of invoking an infinite code path in the computer program.

5427. The computer program of aspect 5426, wherein the infinite code path comprises an infinite loop.

5428. The computer program of aspect 5423, further including a plurality of operators wherein no combination of operators of the plurality of operators are capable of invoking an infinite code path in the computer program.

5429. The computer program of aspect 5428, wherein the infinite code path comprises an infinite loop.

5430. The computer program of aspect 5423, wherein the computer program is a written in a modified version of an existing computer language.

5431. The computer program of aspect 5430 wherein the existing computer language is one of C, C+, C++, Java, Basic, Pascal, and Fortran.

5432. The computer program of aspect 5423 wherein the computer program is written in a computer language wherein each operator of a set consisting of all operators in the computer language has unambiguous semantics and is incapable of an invoking infinite code path alone or in combination with other operators.

5433. The computer program of aspect 5423 wherein the computer program is written in a computer language wherein all programs created in the language have a decidable and complete data flow.

5434. The computer program of aspect 5423 wherein the computer program is written in a computer language wherein a FIOSM can be generated for any program created in the language.

5435. The computer program of aspect 5423 wherein the computer program is written in a computer language wherein the computer program is written in a computer language wherein each operator of a set consisting of all operators in the computer language is incapable of an invoking infinite code path alone or in combination with other operators.

5436. A computer program comprising at least 10,000 lines of code wherein a finite input output model (FIOSM) can be generated for the program.

5437. The computer program of aspect 5436, wherein the computer program does not include operators having ambiguous semantics or operators capable of invoking infinite code paths.

5438. The computer program of aspect 5437, wherein the infinite code paths comprise infinite loops.

5439. The computer program of aspect 5436, further including a plurality of operators wherein not one of the plurality of operators is capable of invoking an infinite code path in the computer program.

5440. The computer program of aspect 5439, wherein the infinite code path comprises an infinite loop.

5441. The computer program of aspect 5436, further including a plurality of operators wherein no combination of operators of the plurality of operators are capable of invoking an infinite code path in the computer program.

5442. The computer program of aspect 5441, wherein the infinite code path comprises an infinite loop.

5443. The computer program of aspect 5436, wherein the computer program is a written in a modified version of an existing computer language.

5444. The computer program of aspect 5443 wherein the existing computer language is one of C, C+, C++, Java, Basic, Pascal, and Fortran.

5445. The computer program of aspect 5436 wherein the computer program is written in a computer language wherein each operator of a set consisting of all operators in the computer language has unambiguous semantics and is incapable of an invoking infinite code path alone or in combination with other operators.

5446. The computer program of aspect 5436 wherein the computer program is written in a computer language wherein all programs created in the language have a decidable and complete data flow.

5447. The computer program of aspect 5436 wherein the computer program is written in a computer language wherein a FIOSM can be generated for any program created in the language.

5448. The computer program of aspect 5436 wherein the computer program is written in a computer language wherein the computer program is written in a computer language wherein each operator of a set consisting of all operators in the computer language is incapable of an invoking infinite code path alone or in combination with other operators.

5449. A computer program comprising at least 100,000 lines of code wherein a finite input output model (FIOSM) can be generated for the program.

5450. The computer program of aspect 5449, wherein the computer program does not include operators having ambiguous semantics or operators capable of invoking infinite code paths.

5451. The computer program of aspect 5450, wherein the infinite code paths comprise infinite loops.

5452. The computer program of aspect 5449, further including a plurality of operators wherein not one of the plurality of operators is capable of invoking an infinite code path in the computer program.

5453. The computer program of aspect 5452, wherein the infinite code path comprises an infinite loop.

5454. The computer program of aspect 5449, further including a plurality of operators wherein no combination of operators of the plurality of operators are capable of invoking an infinite code path in the computer program.

5455. The computer program of aspect 5454, wherein the infinite code path comprises an infinite loop.

5456. The computer program of aspect 5449, wherein the computer program is a written in a modified version of an existing computer language.

5457. The computer program of aspect 5456 wherein the existing computer language is one of C, C+, C++, Java, Basic, Pascal, and Fortran.

5458. The computer program of aspect 5449 wherein the computer program is written in a computer language wherein each operator of a set consisting of all operators in the computer language has unambiguous semantics and is incapable of an invoking infinite code path alone or in combination with other operators.

5459. The computer program of aspect 5449 wherein the computer program is written in a computer language wherein all programs created in the language have a decidable and complete data flow.

5460. The computer program of aspect 5449 wherein the computer program is written in a computer language wherein a FIOSM can be generated for any program created in the language.

5461. The computer program of aspect 5449 wherein the computer program is written in a computer language wherein the computer program is written in a computer language wherein each operator of a set consisting of all operators in the computer language is incapable of an invoking infinite code path alone or in combination with other operators.

5462. A computer program comprising at least 1,000,000 lines of code wherein a finite input output model (FIOSM) can be generated for the program.

5463. The computer program of aspect 5462, wherein the computer program does not include operators having ambiguous semantics or operators capable of invoking infinite code paths.

5464. The computer program of aspect 5463, wherein the infinite code paths comprise infinite loops.

5465. The computer program of aspect 5462, further including a plurality of operators wherein not one of the plurality of operators is capable of invoking an infinite code path in the computer program.

5466. The computer program of aspect 5465, wherein the infinite code path comprises an infinite loop.

5467. The computer program of aspect 5462, further including a plurality of operators wherein no combination of operators of the plurality of operators are capable of invoking an infinite code path in the computer program.

5468. The computer program of aspect 5467, wherein the infinite code path comprises an infinite loop.

5469. The computer program of aspect 5462, wherein the computer program is a written in a modified version of an existing computer language.

5470. The computer program of aspect 5469 wherein the existing computer language is one of C, C+, C++, Java, Basic, Pascal, and Fortran.

5471. The computer program of aspect 5462 wherein the computer program is written in a computer language wherein each operator of a set consisting of all operators in the computer language has unambiguous semantics and is incapable of an invoking infinite code path alone or in combination with other operators.

5472. The computer program of aspect 5462 wherein the computer program is written in a computer language wherein all programs created in the language have a decidable and complete data flow.

5473. The computer program of aspect 5462 wherein the computer program is written in a computer language wherein a FIOSM can be generated for any program created in the language.

5474. The computer program of aspect 5462 wherein the computer program is written in a computer language wherein the computer program is written in a computer language wherein each operator of a set consisting of all operators in the computer language is incapable of an invoking infinite code path alone or in combination with other operators.

5475. A software routine governed by a finite input/output semantic (FIOSM) model.

5476. The software routine of aspect 5475, wherein the software routine does not include operators having ambiguous semantics or operators capable of invoking infinite code paths.

5477. The software routine of aspect 5476, wherein the infinite code paths comprise infinite loops.

5478. The software routine of aspect 5475, further including a plurality of operators wherein not one of the plurality of operators is capable of invoking an infinite code path in the software routine.

5479. The software routine of aspect 5478, wherein the infinite code path comprises an infinite loop.

5480. The software routine of aspect 5475, further including a plurality of operators wherein no combination of operators of the plurality of operators are capable of invoking an infinite code path in the software routine.

5481. The software routine of aspect 5480, wherein the infinite code path comprises an infinite loop.

5482. The software routine of aspect 5475, wherein the software routine is a written in a modified version of a preexisting computer language, the modified version having a decidable and complete data flow.

5483. The software routine of aspect 5482 wherein the existing computer language is one of C, C+, C++, Java, Basic, Pascal, and Fortran.

5484. The software routine of aspect 5475 wherein the software routine is written in a computer language wherein each operator of a set consisting of all operators in the computer language has unambiguous semantics and is incapable of an invoking infinite code path alone or in combination with other operators.

5485. The software routine of aspect 5475 wherein the software routine is written in a computer language wherein all routines created in the language have a decidable and complete data flow.

5486. The software routine of aspect 5475 wherein the software routine is written in a computer language wherein a finite input output semantic model can be generated for any software routine created in the language.

5487. The software routine of aspect 5475 wherein the software routine is written in a computer language wherein the software routine is written in a computer language wherein each operator of a set consisting of all operators in the computer language is incapable of an invoking infinite code path alone or in combination with other operators.

5488. The software routine of aspect 5475, comprising at least 100 lines of code.

5489. The software routine of aspect 5476, comprising at least 100 lines of code.

5490. The software routine of aspect 5477, comprising at least 100 lines of code.

5491. The software routine of aspect 5478, comprising at least 100 lines of code.

5492. The software routine of aspect 5479, comprising at least 100 lines of code.

5493. The software routine of aspect 5480, comprising at least 100 lines of code.

5494. The software routine of aspect 5481, comprising at least 100 lines of code.

5495. The software routine of aspect 5482, comprising at least 100 lines of code.

5496. The software routine of aspect 5483, comprising at least 100 lines of code.

5497. The software routine of aspect 5484, comprising at least 100 lines of code.

5498. The software routine of aspect 5485, comprising at least 100 lines of code.

5499. The software routine of aspect 5486, comprising at least 100 lines of code.

5500. The software routine of aspect 5487, comprising at least 100 lines of code.

5501. The software routine of aspect 5475, comprising at least 1,000 lines of code.

5502. The software routine of aspect 5476, comprising at least 1,000 lines of code.

5503. The software routine of aspect 5477, comprising at least 1,000 lines of code.

5504. The software routine of aspect 5478, comprising at least 1,000 lines of code.

5505. The software routine of aspect 5479, comprising at least 1,000 lines of code.

5506. The software routine of aspect 5480, comprising at least 1,000 lines of code.

5507. The software routine of aspect 5481, comprising at least 1,000 lines of code.

5508. The software routine of aspect 5482, comprising at least 1,000 lines of code.

5509. The software routine of aspect 5483, comprising at least 1,000 lines of code.

5510. The software routine of aspect 5484, comprising at least 1,000 lines of code.

5511. The software routine of aspect 5485, comprising at least 1,000 lines of code.

5512. The software routine of aspect 5486, comprising at least 1,000 lines of code.

5513. The software routine of aspect 5487, comprising at least 1,000 lines of code.

5514. The software routine of aspect 5475, comprising at least 10,000 lines of code.

5515. The software routine of aspect 5476, comprising at least 10,000 lines of code.

5516. The software routine of aspect 5477, comprising at least 10,000 lines of code.

5517. The software routine of aspect 5478, comprising at least 10,000 lines of code.

5518. The software routine of aspect 5479, comprising at least 10,000 lines of code.

5519. The software routine of aspect 5480, comprising at least 10,000 lines of code.

5520. The software routine of aspect 5481, comprising at least 10,000 lines of code.

5521. The software routine of aspect 5482, comprising at least 10,000 lines of code.

5522. The software routine of aspect 5483, comprising at least 10,000 lines of code.

5523. The software routine of aspect 5484, comprising at least 10,000 lines of code.

5524. The software routine of aspect 5485, comprising at least 10,000 lines of code.

5525. The software routine of aspect 5486, comprising at least 10,000 lines of code.

5526. The software routine of aspect 5487, comprising at least 10,000 lines of code.

5527. The software routine of aspect 5475, comprising at least 100,000 lines of code.

5528. The software routine of aspect 5476, comprising at least 100,000 lines of code.

5529. The software routine of aspect 5477, comprising at least 100,000 lines of code.

5530. The software routine of aspect 5478, comprising at least 100,000 lines of code.

5531. The software routine of aspect 5479, comprising at least 100,000 lines of code.

5532. The software routine of aspect 5480, comprising at least 100,000 lines of code.

5533. The software routine of aspect 5481, comprising at least 100,000 lines of code.

5534. The software routine of aspect 5482, comprising at least 100,000 lines of code.

5535. The software routine of aspect 5483, comprising at least 100,000 lines of code.

5536. The software routine of aspect 5484, comprising at least 100,000 lines of code.

5537. The software routine of aspect 5485, comprising at least 100,000 lines of code.

5538. The software routine of aspect 5486, comprising at least 100,000 lines of code.

5539. The software routine of aspect 5487, comprising at least 100,000 lines of code.

5540. A software routine wherein all outputs can be mapped to all inputs.

5541. The software routine of aspect 5540, wherein the software routine does not include operators having ambiguous semantics or operators capable of invoking infinite code paths.

5542. The software routine of aspect 5541, wherein the infinite code paths comprise infinite loops.

5543. The software routine of aspect 5540, further including a plurality of operators wherein not one of the plurality of operators is capable of invoking an infinite code path in the software routine.

5544. The software routine of aspect 5543, wherein the infinite code path comprises an infinite loop.

5545. The software routine of aspect 5540, further including a plurality of operators wherein no combination of operators of the plurality of operators are capable of invoking an infinite code path in the software routine.

5546. The software routine of aspect 5545, wherein the infinite code path comprises an infinite loop.

5547. The software routine of aspect 5540, wherein the software routine is a written in a modified version of an existing computer language.

5548. The software routine of aspect 5547 wherein the existing computer language is one of C, C+, C++, Java, Basic, Pascal, and Fortran.

5549. The software routine of aspect 5540 wherein the software routine is written in a computer language wherein each operator of a set consisting of all operators in the computer language has unambiguous semantics and is incapable of an invoking infinite code path alone or in combination with other operators.

5550. The software routine of aspect 5540 wherein the software routine is written in a computer language wherein all routines created in the language have a decidable and complete data flow.

5551. The software routine of aspect 5540 wherein the software routine is written in a computer language wherein a finite input output semantic model can be generated for any routine created in the language.

5552. The software routine of aspect 5540 wherein the software routine is written in a computer language wherein the software routine is written in a computer language wherein each operator of a set consisting of all operators in the computer language is incapable of an invoking infinite code path alone or in combination with other operators.

5553. The software routine of aspect 5540, comprising at least 100 lines of code.

5554. The software routine of aspect 5541, comprising at least 100 lines of code.

5555. The software routine of aspect 5542, comprising at least 100 lines of code.

5556. The software routine of aspect 5543, comprising at least 100 lines of code.

5557. The software routine of aspect 5544, comprising at least 100 lines of code.

5558. The software routine of aspect 5545, comprising at least 100 lines of code.

5559. The software routine of aspect 5546, comprising at least 100 lines of code.

5560. The software routine of aspect 5547, comprising at least 100 lines of code.

5561. The software routine of aspect 5548, comprising at least 100 lines of code.

5562. The software routine of aspect 5549, comprising at least 100 lines of code.

5563. The software routine of aspect 5550, comprising at least 100 lines of code.

5564. The software routine of aspect 5551, comprising at least 100 lines of code.

5565. The software routine of aspect 5552, comprising at least 100 lines of code.

5566. The software routine of aspect 5540, comprising at least 1,000 lines of code.

5567. The software routine of aspect 5541, comprising at least 1,000 lines of code.

5568. The software routine of aspect 5542, comprising at least 1,000 lines of code.

5569. The software routine of aspect 5543, comprising at least 1,000 lines of code.

5570. The software routine of aspect 5544, comprising at least 1,000 lines of code.

5571. The software routine of aspect 5545, comprising at least 1,000 lines of code.

5572. The software routine of aspect 5546, comprising at least 1,000 lines of code.

5573. The software routine of aspect 5547, comprising at least 1,000 lines of code.

5574. The software routine of aspect 5548, comprising at least 1,000 lines of code.

5575. The software routine of aspect 5549, comprising at least 1,000 lines of code.

5576. The software routine of aspect 5550, comprising at least 1,000 lines of code.

5577. The software routine of aspect 5551, comprising at least 1,000 lines of code.

5578. The software routine of aspect 5552, comprising at least 1,000 lines of code.

5579. The software routine of aspect 5540, comprising at least 10,000 lines of code.

5580. The software routine of aspect 5541, comprising at least 10,000 lines of code.

5581. The software routine of aspect 5542, comprising at least 10,000 lines of code.

5582. The software routine of aspect 5543, comprising at least 10,000 lines of code.

5583. The software routine of aspect 5544, comprising at least 10,000 lines of code.

5584. The software routine of aspect 5545, comprising at least 10,000 lines of code.

5585. The software routine of aspect 5546, comprising at least 10,000 lines of code.

5586. The software routine of aspect 5547, comprising at least 10,000 lines of code.

5587. The software routine of aspect 5548, comprising at least 10,000 lines of code.

5588. The software routine of aspect 5549, comprising at least 10,000 lines of code.

5589. The software routine of aspect 5550, comprising at least 10,000 lines of code.

5590. The software routine of aspect 5551, comprising at least 10,000 lines of code.

5591. The software routine of aspect 5552, comprising at least 10,000 lines of code.

5592. The software routine of aspect 5540, comprising at least 100,000 lines of code.

5593. The software routine of aspect 5541, comprising at least 100,000 lines of code.

5594. The software routine of aspect 5542, comprising at least 100,000 lines of code.

5595. The software routine of aspect 5543, comprising at least 100,000 lines of code.

5596. The software routine of aspect 5544, comprising at least 100,000 lines of code.

5597. The software routine of aspect 5545, comprising at least 100,000 lines of code.

5598. The software routine of aspect 5546, comprising at least 100,000 lines of code.

5599. The software routine of aspect 5547, comprising at least 100,000 lines of code.

5600. The software routine of aspect 5548, comprising at least 100,000 lines of code.

5601. The software routine of aspect 5549, comprising at least 100,000 lines of code.

5602. The software routine of aspect 5550, comprising at least 10,000 lines of code.

5603. The software routine of aspect 5551, comprising at least 10,000 lines of code.

5604. The software routine of aspect 5552, comprising at least 10,000 lines of code.

5605. A software routine having a finite set of input and output patterns.

5606. The software routine of aspect 5605, wherein the software routine does not include operators having ambiguous semantics or operators capable of invoking infinite code paths.

5607. The software routine of aspect 5606, wherein the infinite code paths comprise infinite loops.

5608. The software routine of aspect 5605, further including a plurality of operators wherein not one of the plurality of operators is capable of invoking an infinite code path in the software routine.

5609. The software routine of aspect 5608, wherein the infinite code path comprises an infinite loop.

5610. The software routine of aspect 5605, further including a plurality of operators wherein no combination of operators of the plurality of operators are capable of invoking an infinite code path in the software routine.

5611. The software routine of aspect 5610, wherein the infinite code path comprises an infinite loop.

5612. The software routine of aspect 5605, wherein the software routine is a written in a modified version of an existing computer language.

5613. The software routine of aspect 5612 wherein the existing computer language is one of C, C+, C++, Java, Basic, Pascal, and Fortran.

5614. The software routine of aspect 5605 wherein the software routine is written in a computer language wherein each operator of a set consisting of all operators in the computer language has unambiguous semantics and is incapable of an invoking infinite code path alone or in combination with other operators.

5615. The software routine of aspect 5605 wherein the software routine is written in a computer language wherein all routines created in the language have a decidable and complete data flow.

5616. The software routine of aspect 5605 wherein the software routine is written in a computer language wherein a finite input output semantic model can be generated for any routine created in the language.

5617. The software routine of aspect 5605 wherein the software routine is written in a computer language wherein the software routine is written in a computer language wherein each operator of a set consisting of all operators in the computer language is incapable of an invoking infinite code path alone or in combination with other operators.

5618. The software routine of aspect 5605, comprising at least 100 lines of code.

5619. The software routine of aspect 5606, comprising at least 100 lines of code.

5620. The software routine of aspect 5607, comprising at least 100 lines of code.

5621. The software routine of aspect 5608, comprising at least 100 lines of code.

5622. The software routine of aspect 5609, comprising at least 100 lines of code.

5623. The software routine of aspect 5610, comprising at least 100 lines of code.

5624. The software routine of aspect 5611, comprising at least 100 lines of code.

5625. The software routine of aspect 5612, comprising at least 100 lines of code.

5626. The software routine of aspect 5613, comprising at least 100 lines of code.

5627. The software routine of aspect 5614, comprising at least 100 lines of code.

5628. The software routine of aspect 5615, comprising at least 100 lines of code.

5629. The software routine of aspect 5616, comprising at least 100 lines of code.

5630. The software routine of aspect 5617, comprising at least 100 lines of code.

5631. The software routine of aspect 5605, comprising at least 1,000 lines of code.

5632. The software routine of aspect 5606, comprising at least 1,000 lines of code.

5633. The software routine of aspect 5607, comprising at least 1,000 lines of code.

5634. The software routine of aspect 5608, comprising at least 1,000 lines of code.

5635. The software routine of aspect 5609, comprising at least 1,000 lines of code.

5636. The software routine of aspect 5610, comprising at least 1,000 lines of code.

5637. The software routine of aspect 5611, comprising at least 1,000 lines of code.

5638. The software routine of aspect 5612, comprising at least 1,000 lines of code.

5639. The software routine of aspect 5613, comprising at least 1,000 lines of code.

5640. The software routine of aspect 5614, comprising at least 1,000 lines of code.

5641. The software routine of aspect 5615, comprising at least 1,000 lines of code.

5642. The software routine of aspect 5616, comprising at least 1,000 lines of code.

5643. The software routine of aspect 5617, comprising at least 1,000 lines of code.

5644. The software routine of aspect 5605, comprising at least 10,000 lines of code.

5645. The software routine of aspect 5606, comprising at least 10,000 lines of code.

5646. The software routine of aspect 5607, comprising at least 10,000 lines of code.

5647. The software routine of aspect 5608, comprising at least 10,000 lines of code.

5648. The software routine of aspect 5609, comprising at least 10,000 lines of code.

5649. The software routine of aspect 5610, comprising at least 10,000 lines of code.

5650. The software routine of aspect 5611, comprising at least 10,000 lines of code.

5651. The software routine of aspect 5612, comprising at least 10,000 lines of code.

5652. The software routine of aspect 5613, comprising at least 10,000 lines of code.

5653. The software routine of aspect 5614, comprising at least 10,000 lines of code.

5654. The software routine of aspect 5615, comprising at least 10,000 lines of code.

5655. The software routine of aspect 5616, comprising at least 10,000 lines of code.

5656. The software routine of aspect 5617, comprising at least 10,000 lines of code.

5657. The software routine of aspect 5605, comprising at least 100,000 lines of code.

5658. The software routine of aspect 5606, comprising at least 100,000 lines of code.

5659. The software routine of aspect 5607, comprising at least 100,000 lines of code.

5660. The software routine of aspect 5608, comprising at least 100,000 lines of code.

5661. The software routine of aspect 5609, comprising at least 100,000 lines of code.

5662. The software routine of aspect 5610, comprising at least 100,000 lines of code.

5663. The software routine of aspect 5611, comprising at least 100,000 lines of code.

5664. The software routine of aspect 5612, comprising at least 100,000 lines of code.

5665. The software routine of aspect 5613, comprising at least 100,000 lines of code.

5666. The software routine of aspect 5614, comprising at least 100,000 lines of code.

5667. The software routine of aspect 5615, comprising at least 100,000 lines of code.

5668. The software routine of aspect 5616, comprising at least 100,000 lines of code.

5669. The software routine of aspect 5617, comprising at least 100,000 lines of code.

5670. A software routine having completely decidable data flow.

5671. The software routine of aspect 5670, wherein the software routine does not include operators having ambiguous semantics or operators capable of invoking infinite code paths.

5672. The software routine of aspect 5671, wherein the infinite code paths comprise infinite loops.

5673. The software routine of aspect 5670, further including a plurality of operators wherein not one of the plurality of operators is capable of invoking an infinite code path in the software routine.

5674. The software routine of aspect 5673, wherein the infinite code path comprises an infinite loop.

5675. The software routine of aspect 5670, further including a plurality of operators wherein no combination of operators of the plurality of operators are capable of invoking an infinite code path in the software routine.

5676. The software routine of aspect 5675, wherein the infinite code path comprises an infinite loop.

5677. The software routine of aspect 5670, wherein the software routine is a written in a modified version of an existing computer language.

5678. The software routine of aspect 5677 wherein the existing computer language is one of C, C+, C++, Java, Basic, Pascal, and Fortran.

5679. The software routine of aspect 5670 wherein the software routine is written in a computer language wherein each operator of a set consisting of all operators in the computer language has unambiguous semantics and is incapable of an invoking infinite code path alone or in combination with other operators.

5680. The software routine of aspect 5670 wherein the software routine is written in a computer language wherein all routines created in the language have a decidable and complete data flow.

5681. The software routine of aspect 5670 wherein the software routine is written in a computer language wherein a finite input output semantic model can be generated for any routine created in the language.

5682. The software routine of aspect 5670 wherein the software routine is written in a computer language wherein the software routine is written in a computer language wherein each operator of a set consisting of all operators in the computer language is incapable of an invoking infinite code path alone or in combination with other operators.

5683. The software routine of aspect 5670, comprising at least 100 lines of code.

5684. The software routine of aspect 5671, comprising at least 100 lines of code.

5685. The software routine of aspect 5672, comprising at least 100 lines of code.

5686. The software routine of aspect 5673, comprising at least 100 lines of code.

5687. The software routine of aspect 5674, comprising at least 100 lines of code.

5688. The software routine of aspect 5675, comprising at least 100 lines of code.

5689. The software routine of aspect 5676, comprising at least 100 lines of code.

5690. The software routine of aspect 5677, comprising at least 100 lines of code.

5691. The software routine of aspect 5678, comprising at least 100 lines of code.

5692. The software routine of aspect 5679, comprising at least 100 lines of code.

5693. The software routine of aspect 5680, comprising at least 100 lines of code.

5694. The software routine of aspect 5681, comprising at least 100 lines of code.

5695. The software routine of aspect 5682, comprising at least 100 lines of code.

5696. The software routine of aspect 5670, comprising at least 1,000 lines of code.

5697. The software routine of aspect 5671, comprising at least 1,000 lines of code.

5698. The software routine of aspect 5672, comprising at least 1,000 lines of code.

5699. The software routine of aspect 5673, comprising at least 1,000 lines of code.

5700. The software routine of aspect 5674, comprising at least 1,000 lines of code.

5701. The software routine of aspect 5675, comprising at least 1,000 lines of code.

5702. The software routine of aspect 5676, comprising at least 1,000 lines of code.

5703. The software routine of aspect 5677, comprising at least 1,000 lines of code.

5704. The software routine of aspect 5678, comprising at least 1,000 lines of code.

5705. The software routine of aspect 5679, comprising at least 1,000 lines of code.

5706. The software routine of aspect 5680, comprising at least 1,000 lines of code.

5707. The software routine of aspect 5681, comprising at least 1,000 lines of code.

5708. The software routine of aspect 5682, comprising at least 1,000 lines of code.

5709. The software routine of aspect 5670, comprising at least 10,000 lines of code.

5710. The software routine of aspect 5671, comprising at least 10,000 lines of code.

5711. The software routine of aspect 5672, comprising at least 10,000 lines of code.

5712. The software routine of aspect 5673, comprising at least 10,000 lines of code.

5713. The software routine of aspect 5674, comprising at least 10,000 lines of code.

5714. The software routine of aspect 5675, comprising at least 10,000 lines of code.

5715. The software routine of aspect 5676, comprising at least 10,000 lines of code.

5716. The software routine of aspect 5677, comprising at least 10,000 lines of code.

5717. The software routine of aspect 5678, comprising at least 10,000 lines of code.

5718. The software routine of aspect 5679, comprising at least 10,000 lines of code.

5719. The software routine of aspect 5680, comprising at least 10,000 lines of code.

5720. The software routine of aspect 5681, comprising at least 10,000 lines of code.

5721. The software routine of aspect 5682, comprising at least 10,000 lines of code.

5722. The software routine of aspect 5670, comprising at least 100,000 lines of code.

5723. The software routine of aspect 5671, comprising at least 100,000 lines of code.

5724. The software routine of aspect 5672, comprising at least 100,000 lines of code.

5725. The software routine of aspect 5673, comprising at least 100,000 lines of code.

5726. The software routine of aspect 5674, comprising at least 100,000 lines of code.

5727. The software routine of aspect 5675, comprising at least 100,000 lines of code.

5728. The software routine of aspect 5676, comprising at least 100,000 lines of code.

5729. The software routine of aspect 5677, comprising at least 100,000 lines of code.

5730. The software routine of aspect 5678, comprising at least 100,000 lines of code.

5731. The software routine of aspect 5679, comprising at least 100,000 lines of code.

5732. The software routine of aspect 5680, comprising at least 100,000 lines of code.

5733. The software routine of aspect 5681, comprising at least 100,000 lines of code.

5734. The software routine of aspect 5682, comprising at least 100,000 lines of code.

5735. A software routine embodying the finite code path property.

5736. The software routine of aspect 5735, wherein the software routine does not include operators having ambiguous semantics or operators capable of invoking infinite code paths.

5737. The software routine of aspect 5736, wherein the infinite code paths comprise infinite loops.

5738. The software routine of aspect 5735, further including a plurality of operators wherein not one of the plurality of operators is capable of invoking an infinite code path in the software routine.

5739. The software routine of aspect 5738, wherein the infinite code path comprises an infinite loop.

5740. The software routine of aspect 5735, further including a plurality of operators wherein no combination of operators of the plurality of operators are capable of invoking an infinite code path in the software routine.

5741. The software routine of aspect 5740, wherein the infinite code path comprises an infinite loop.

5742. The software routine of aspect 5735, wherein the software routine is a written in a modified version of an existing computer language.

5743. The software routine of aspect 5742 wherein the existing computer language is one of C, C+, C++, Java, Basic, Pascal, and Fortran.

5744. The software routine of aspect 5735 wherein the software routine is written in a computer language wherein each operator of a set consisting of all operators in the computer language has unambiguous semantics and is incapable of an invoking infinite code path alone or in combination with other operators.

5745. The software routine of aspect 5735 wherein the software routine is written in a computer language wherein all routines created in the language have a decidable and complete data flow.

5746. The software routine of aspect 5735 wherein the software routine is written in a computer language wherein a finite input output semantic model can be generated for any routine created in the language.

5747. The software routine of aspect 5735 wherein the software routine is written in a computer language wherein the software routine is written in a computer language wherein each operator of a set consisting of all operators in the computer language is incapable of an invoking infinite code path alone or in combination with other operators.

5748. The software routine of aspect 5735, comprising at least 100 lines of code.

5749. The software routine of aspect 5736, comprising at least 100 lines of code.

5750. The software routine of aspect 5737, comprising at least 100 lines of code.

5751. The software routine of aspect 5738, comprising at least 100 lines of code.

5752. The software routine of aspect 5739, comprising at least 100 lines of code.

5753. The software routine of aspect 5740, comprising at least 100 lines of code.

5754. The software routine of aspect 5741, comprising at least 100 lines of code.

5755. The software routine of aspect 5742, comprising at least 100 lines of code.

5756. The software routine of aspect 5743, comprising at least 100 lines of code.

5757. The software routine of aspect 5744, comprising at least 100 lines of code.

5758. The software routine of aspect 5745, comprising at least 100 lines of code.

5759. The software routine of aspect 5746, comprising at least 100 lines of code.

5760. The software routine of aspect 5747, comprising at least 100 lines of code.

5761. The software routine of aspect 5735, comprising at least 1,000 lines of code.

5762. The software routine of aspect 5736, comprising at least 1,000 lines of code.

5763. The software routine of aspect 5737, comprising at least 1,000 lines of code.

5764. The software routine of aspect 5738, comprising at least 1,000 lines of code.

5765. The software routine of aspect 5739, comprising at least 1,000 lines of code.

5766. The software routine of aspect 5740, comprising at least 1,000 lines of code.

5767. The software routine of aspect 5741, comprising at least 1,000 lines of code.

5768. The software routine of aspect 5742, comprising at least 1,000 lines of code.

5769. The software routine of aspect 5743, comprising at least 1,000 lines of code.

5770. The software routine of aspect 5744, comprising at least 1,000 lines of code.

5771. The software routine of aspect 5745, comprising at least 1,000 lines of code.

5772. The software routine of aspect 5746, comprising at least 1,000 lines of code.

5773. The software routine of aspect 5747, comprising at least 1,000 lines of code.

5774. The software routine of aspect 5735, comprising at least 10,000 lines of code.

5775. The software routine of aspect 5736, comprising at least 10,000 lines of code.

5776. The software routine of aspect 5737, comprising at least 10,000 lines of code.

5777. The software routine of aspect 5738, comprising at least 10,000 lines of code.

5778. The software routine of aspect 5739, comprising at least 10,000 lines of code.

5779. The software routine of aspect 5740, comprising at least 10,000 lines of code.

5780. The software routine of aspect 5741, comprising at least 10,000 lines of code.

5781. The software routine of aspect 5742, comprising at least 10,000 lines of code.

5782. The software routine of aspect 5743, comprising at least 10,000 lines of code.

5783. The software routine of aspect 5744, comprising at least 10,000 lines of code.

5784. The software routine of aspect 5745, comprising at least 10,000 lines of code.

5785. The software routine of aspect 5746, comprising at least 10,000 lines of code.

5786. The software routine of aspect 5747, comprising at least 10,000 lines of code.

5787. The software routine of aspect 5735, comprising at least 100,000 lines of code.

5788. The software routine of aspect 5736, comprising at least 100,000 lines of code.

5789. The software routine of aspect 5737, comprising at least 100,000 lines of code.

5790. The software routine of aspect 5738, comprising at least 100,000 lines of code.

5791. The software routine of aspect 5739, comprising at least 100,000 lines of code.

5792. The software routine of aspect 5740, comprising at least 100,000 lines of code.

5793. The software routine of aspect 5741, comprising at least 100,000 lines of code.

5794. The software routine of aspect 5742, comprising at least 100,000 lines of code.

5795. The software routine of aspect 5743, comprising at least 100,000 lines of code.

5796. The software routine of aspect 5744, comprising at least 100,000 lines of code.

5797. The software routine of aspect 5745, comprising at least 100,000 lines of code.

5798. The software routine of aspect 5746, comprising at least 100,000 lines of code.

5799. The software routine of aspect 5747, comprising at least 100,000 lines of code.

5800. A software routine compatible with a finite input output model (FIOSM).

5801. The software routine of aspect 5800, wherein the software routine does not include control flow operators having ambiguous semantics or control flow operators capable of invoking infinite code paths.

5802. The software routine of aspect 5801, wherein the infinite code paths comprise infinite loops.

5803. The software routine of aspect 5800, further including a plurality of operators wherein not one of the plurality of operators is capable of invoking an infinite code path in the software routine.

5804. The software routine of aspect 5803, wherein the infinite code path comprises an infinite loop.

5805. The software routine of aspect 5800, further including a plurality of operators wherein no combination of operators of the plurality of operators are capable of invoking an infinite code path in the software routine.

5806. The software routine of aspect 5805, wherein the infinite code path comprises an infinite loop.

5807. The software routine of aspect 5800, wherein the software routine is a written in a modified version of an existing computer language.

5808. The software routine of aspect 5807 wherein the existing computer language is one of C, C+, C++, Java, Basic, Pascal, and Fortran.

5809. The software routine of aspect 5800 wherein the software routine is written in a computer language wherein each operator of a set consisting of all operators in the computer language has unambiguous semantics and is incapable of an invoking infinite code path alone or in combination with other operators.

5810. The software routine of aspect 5800 wherein the software routine is written in a computer language wherein all routines created in the language have a decidable and complete data flow.

5811. The software routine of aspect 5800 wherein the software routine is written in a computer language wherein a finite input output semantic model can be generated for any routine created in the language.

5812. The software routine of aspect 5800 wherein the software routine is written in a computer language wherein the software routine is written in a computer language wherein each operator of a set consisting of all operators in the computer language is incapable of an invoking infinite code path alone or in combination with other operators.

5813. The software routine of aspect 5800, comprising at least 100 lines of code.

5814. The software routine of aspect 5801, comprising at least 100 lines of code.

5815. The software routine of aspect 5802, comprising at least 100 lines of code.

5816. The software routine of aspect 5803, comprising at least 100 lines of code.

5817. The software routine of aspect 5804, comprising at least 100 lines of code.

5818. The software routine of aspect 5805, comprising at least 100 lines of code.

5819. The software routine of aspect 5806, comprising at least 100 lines of code.

5820. The software routine of aspect 5807, comprising at least 100 lines of code.

5821. The software routine of aspect 5808, comprising at least 100 lines of code.

5822. The software routine of aspect 5809, comprising at least 100 lines of code.

5823. The software routine of aspect 5810, comprising at least 100 lines of code.

5824. The software routine of aspect 5811, comprising at least 100 lines of code.

5825. The software routine of aspect 5812, comprising at least 100 lines of code.

5826. The software routine of aspect 5800, comprising at least 1,000 lines of code.

5827. The software routine of aspect 5801, comprising at least 1,000 lines of code.

5828. The software routine of aspect 5802, comprising at least 1,000 lines of code.

5829. The software routine of aspect 5803, comprising at least 1,000 lines of code.

5830. The software routine of aspect 5804, comprising at least 1,000 lines of code.

5831. The software routine of aspect 5805, comprising at least 1,000 lines of code.

5832. The software routine of aspect 5806, comprising at least 1,000 lines of code.

5833. The software routine of aspect 5807, comprising at least 1,000 lines of code.

5834. The software routine of aspect 5808, comprising at least 1,000 lines of code.

5835. The software routine of aspect 5809, comprising at least 1,000 lines of code.

5836. The software routine of aspect 5810, comprising at least 1,000 lines of code.

5837. The software routine of aspect 5811, comprising at least 1,000 lines of code.

5838. The software routine of aspect 5812, comprising at least 1,000 lines of code.

5839. The software routine of aspect 5800, comprising at least 10,000 lines of code.

5840. The software routine of aspect 5801, comprising at least 10,000 lines of code.

5841. The software routine of aspect 5802, comprising at least 10,000 lines of code.

5842. The software routine of aspect 5803, comprising at least 10,000 lines of code.

5843. The software routine of aspect 5804, comprising at least 10,000 lines of code.

5844. The software routine of aspect 5805, comprising at least 10,000 lines of code.

5845. The software routine of aspect 5806, comprising at least 10,000 lines of code.

5846. The software routine of aspect 5807, comprising at least 10,000 lines of code.

5847. The software routine of aspect 5808, comprising at least 10,000 lines of code.

5848. The software routine of aspect 5809, comprising at least 10,000 lines of code.

5849. The software routine of aspect 5810, comprising at least 10,000 lines of code.

5850. The software routine of aspect 5811, comprising at least 10,000 lines of code.

5851. The software routine of aspect 5812, comprising at least 10,000 lines of code.

5852. The software routine of aspect 5800, comprising at least 100,000 lines of code.

5853. The software routine of aspect 5801, comprising at least 100,000 lines of code.

5854. The software routine of aspect 5802, comprising at least 100,000 lines of code.

5855. The software routine of aspect 5803, comprising at least 100,000 lines of code.

5856. The software routine of aspect 5804, comprising at least 100,000 lines of code.

5857. The software routine of aspect 5805, comprising at least 100,000 lines of code.

5858. The software routine of aspect 5806, comprising at least 100,000 lines of code.

5859. The software routine of aspect 5807, comprising at least 100,000 lines of code.

5860. The software routine of aspect 5808, comprising at least 100,000 lines of code.

5861. The software routine of aspect 5809, comprising at least 100,000 lines of code.

5862. The software routine of aspect 5810, comprising at least 100,000 lines of code.

5863. The software routine of aspect 5811, comprising at least 100,000 lines of code.

5864. The software routine of aspect 5812, comprising at least 100,000 lines of code.

5865. A software routine wherein a finite input output model (FIOSM) can be generated for the software routine.

5866. The software routine of aspect 5865, wherein the software routine does not include operators having ambiguous semantics or operators capable of invoking infinite code paths.

5867. The software routine of aspect 5866, wherein the infinite code paths comprise infinite loops.

5868. The software routine of aspect 5865, further including a plurality of operators wherein not one of the plurality of operators is capable of invoking an infinite code path in the software routine.

5869. The software routine of aspect 5868, wherein the infinite code path comprises an infinite loop.

5870. The software routine of aspect 5865, further including a plurality of operators wherein no combination of operators of the plurality of operators are capable of invoking an infinite code path in the software routine.

5871. The software routine of aspect 5870, wherein the infinite code path comprises an infinite loop.

5872. The software routine of aspect 5865, wherein the software routine is a written in a modified version of an existing computer language.

5873. The software routine of aspect 5872 wherein the existing computer language is one of C, C+, C++, Java, Basic, Pascal, and Fortran.

5874. The software routine of aspect 5865 wherein the software routine is written in a computer language wherein each operator of a set consisting of all operators in the computer language has unambiguous semantics and is incapable of an invoking infinite code path alone or in combination with other operators.

5875. The software routine of aspect 5865 wherein the software routine is written in a computer language wherein all routines created in the language have a decidable and complete data flow.

5876. The software routine of aspect 5865 wherein the software routine is written in a computer language wherein a FIOSM can be generated for any routine created in the language.

5877. The software routine of aspect 5865 wherein the software routine is written in a computer language wherein the software routine is written in a computer language wherein each operator of a set consisting of all operators in the computer language is incapable of an invoking infinite code path alone or in combination with other operators.

5878. A software routine comprising at least 1,000 lines of code wherein a finite input output model (FIOSM) can be generated for the software routine.

5879. The software routine of aspect 5878, wherein the software routine does not include operators having ambiguous semantics or operators capable of invoking infinite code paths.

5880. The software routine of aspect 5879, wherein the infinite code paths comprise infinite loops.

5881. The software routine of aspect 5878, further including a plurality of operators wherein not one of the plurality of operators is capable of invoking an infinite code path in the software routine.

5882. The software routine of aspect 5881, wherein the infinite code path comprises an infinite loop.

5883. The software routine of aspect 5878, further including a plurality of operators wherein no combination of operators of the plurality of operators are capable of invoking an infinite code path in the software routine.

5884. The software routine of aspect 5883, wherein the infinite code path comprises an infinite loop.

5885. The software routine of aspect 5878, wherein the software routine is a written in a modified version of an existing computer language.

5886. The software routine of aspect 5885 wherein the existing computer language is one of C, C+, C++, Java, Basic, Pascal, and Fortran.

5887. The software routine of aspect 5878 wherein the software routine is written in a computer language wherein each operator of a set consisting of all operators in the computer language has unambiguous semantics and is incapable of an invoking infinite code path alone or in combination with other operators.

5888. The software routine of aspect 5878 wherein the software routine is written in a computer language wherein all routines created in the language have a decidable and complete data flow.

5889. The software routine of aspect 5878 wherein the software routine is written in a computer language wherein a FIOSM can be generated for any routine created in the language.

5890. The software routine of aspect 5878 wherein the software routine is written in a computer language wherein the software routine is written in a computer language wherein each operator of a set consisting of all operators in the computer language is incapable of an invoking infinite code path alone or in combination with other operators.

5891. A software routine comprising at least 10,000 lines of code wherein a finite input output model (FIOSM) can be generated for the software routine.

5892. The software routine of aspect 5891, wherein the software routine does not include operators having ambiguous semantics or operators capable of invoking infinite code paths.

5893. The software routine of aspect 5892, wherein the infinite code paths comprise infinite loops.

5894. The software routine of aspect 5891, further including a plurality of operators wherein not one of the plurality of operators is capable of invoking an infinite code path in the software routine.

5895. The software routine of aspect 5894, wherein the infinite code path comprises an infinite loop.

5896. The software routine of aspect 5891, further including a plurality of operators wherein no combination of operators of the plurality of operators are capable of invoking an infinite code path in the software routine.

5897. The software routine of aspect 5896, wherein the infinite code path comprises an infinite loop.

5898. The software routine of aspect 5891, wherein the software routine is a written in a modified version of an existing computer language.

5899. The software routine of aspect 5898 wherein the existing computer language is one of C, C+, C++, Java, Basic, Pascal, and Fortran.

5900. The software routine of aspect 5891 wherein the software routine is written in a computer language wherein each operator of a set consisting of all operators in the computer language has unambiguous semantics and is incapable of an invoking infinite code path alone or in combination with other operators.

5901. The software routine of aspect 5891 wherein the software routine is written in a computer language wherein all routines created in the language have a decidable and complete data flow.

5902. The software routine of aspect 5891 wherein the software routine is written in a computer language wherein a FIOSM can be generated for any routine created in the language.

5903. The software routine of aspect 5891 wherein the software routine is written in a computer language wherein the software routine is written in a computer language wherein each operator of a set consisting of all operators in the computer language is incapable of an invoking infinite code path alone or in combination with other operators.

5904. A software routine comprising at least 100,000 lines of code wherein a finite input output model (FIOSM) can be generated for the software routine.

5905. The software routine of aspect 5904, wherein the software routine does not include operators having ambiguous semantics or operators capable of invoking infinite code paths.

5906. The software routine of aspect 5905, wherein the infinite code paths comprise infinite loops.

5907. The software routine of aspect 5904, further including a plurality of operators wherein not one of the plurality of operators is capable of invoking an infinite code path in the software routine.

5908. The software routine of aspect 5907, wherein the infinite code path comprises an infinite loop.

5909. The software routine of aspect 5904, further including a plurality of operators wherein no combination of operators of the plurality of operators are capable of invoking an infinite code path in the software routine.

5910. The software routine of aspect 5909, wherein the infinite code path comprises an infinite loop.

5911. The software routine of aspect 5904, wherein the software routine is a written in a modified version of an existing computer language.

5912. The software routine of aspect 5911 wherein the existing computer language is one of C, C+, C++, Java, Basic, Pascal, and Fortran.

5913. The software routine of aspect 5904 wherein the software routine is written in a computer language wherein each operator of a set consisting of all operators in the computer language has unambiguous semantics and is incapable of an invoking infinite code path alone or in combination with other operators.

5914. The software routine of aspect 5904 wherein the software routine is written in a computer language wherein all routines created in the language have a decidable and complete data flow.

5915. The software routine of aspect 5904 wherein the software routine is written in a computer language wherein a FIOSM can be generated for any routine created in the language.

5916. The software routine of aspect 5904 wherein the software routine is written in a computer language wherein the software routine is written in a computer language wherein each operator of a set consisting of all operators in the computer language is incapable of an invoking infinite code path alone or in combination with other operators.

5917. A software routine comprising at least 1,000,000 lines of code wherein a finite input output model (FIOSM) can be generated for the software routine.

5918. The software routine of aspect 5917, wherein the software routine does not include operators having ambiguous semantics or operators capable of invoking infinite code paths.

5919. The software routine of aspect 5918, wherein the infinite code paths comprise infinite loops.

5920. The software routine of aspect 5917, further including a plurality of operators wherein not one of the plurality of operators is capable of invoking an infinite code path in the software routine.

5921. The software routine of aspect 5920, wherein the infinite code path comprises an infinite loop.

5922. The software routine of aspect 5917, further including a plurality of operators wherein no combination of operators of the plurality of operators are capable of invoking an infinite code path in the software routine.

5923. The software routine of aspect 5922, wherein the infinite code path comprises an infinite loop.

5924. The software routine of aspect 5917, wherein the software routine is a written in a modified version of an existing computer language.

5925. The software routine of aspect 5924 wherein the existing computer language is one of C, C+, C++, Java, Basic, Pascal, and Fortran.

5926. The software routine of aspect 5917 wherein the software routine is written in a computer language wherein each operator of a set consisting of all operators in the computer language has unambiguous semantics and is incapable of an invoking infinite code path alone or in combination with other operators.

5927. The software routine of aspect 5917 wherein the software routine is written in a computer language wherein all routines created in the language have a decidable and complete data flow.

5928. The software routine of aspect 5917 wherein the software routine is written in a computer language wherein a FIOSM can be generated for any routine created in the language.

5929. The software routine of aspect 5917 wherein the software routine is written in a computer language wherein the software routine is written in a computer language wherein each operator of a set consisting of all operators in the computer language is incapable of an invoking infinite code path alone or in combination with other operators.

5930. An invention as substantially shown and/or described.

5931. A method as substantially shown and/or described.

5932. A computer language as substantially shown and/or described.

5933. A software language as substantially shown and/or described.

5934. A computer procedure as substantially shown and/or described.

5935. A computer module as substantially shown and/or described.

5936. A computer routine as substantially shown and/or described.

5937. An enterprise system as substantially shown and/or described.

5938. A computer program as substantially shown and/or described.

5939. A modified software language as substantially shown and/or described.

5940. A computer system as substantially shown and/or described.

5941. A machine as substantially shown and/or described.

5942. One or more machines as substantially shown and/or described.

5943. A general purpose computing machines as substantially shown and/or described.

5944. A machine-readable medium as substantially shown and/or described.

5945. A signal carrier wave as substantially shown and/or described.

5946. The method as outlined in FIG. 8 and described in this disclosure.

5947. The method as outlined in FIG. 20 and described in this disclosure.

5948. Any one or more features of the invention as substantially described herein.

5949. Any combination of features as substantially described herein.

5950. A means capable of performing any combination of features as substantially described herein.

5951. A means capable of performing any one or more of features as substantially described herein.

5951. A module capable of performing any one or more of features as substantially described herein.

5952. The module of aspect 5951, wherein the module is one or more of hardware, software and firmware.

5953. A module adapted to perform any one or more of features as substantially described herein.

5954. The module of aspect 5951, wherein the module is one or more of hardware, software and firmware.

5955. A program, stored on a storage media, that when executed performs any one or more of features as substantially described herein.

5956. Any one or more of the features described herein applied to a legacy software application.

5957. Any one or more of the features described herein applied to a legacy software program.

5958. Any one or more of the features described herein applied to a legacy software routine.

5959. Any one or more of the features described herein applied to a portion of a legacy software application.

5960. The method of aspect 18 wherein the software program is capable of performing at least 1,000 distinct operations when executed.

5961. The method of aspect 18 wherein the software program is capable of performing at least 10,000 distinct operations when executed.

5962. The method of aspect 18 wherein the software program is capable of performing at least 100,000 distinct operations when executed.

5963. The method of aspect 18 wherein the software program is capable of performing at least 1,000,000 distinct operations when executed.

5965. The method of aspect 401 wherein the software program is capable of performing at least 1,000 distinct operations when executed.

5966. The method of aspect 401 wherein the software program is capable of performing at least 10,000 distinct operations when executed.

5967. The method of aspect 401 wherein the software program is capable of performing at least 100,000 distinct operations when executed.

5968. The method of aspect 401 wherein the software program is capable of performing at least 1,000,000 distinct operations when executed.

5969. The method of aspect 559 wherein the software procedure is capable of performing at least 1,000 distinct operations when executed.

5970. The method of aspect 559 wherein the software procedure is capable of performing at least 10,000 distinct operations when executed.

5971. The method of aspect 559 wherein the software procedure is capable of performing at least 100,000 distinct operations when executed.

5972. The method of aspect 559 wherein the software procedure is capable of performing at least 1,000,000 distinct operations when executed.

5973. The method of aspect 606 wherein the software routine is capable of performing at least 1,000 distinct operations when executed.

5974. The method of aspect 606 wherein the software routine is capable of performing at least 10,000 distinct operations when executed.

5975. The method of aspect 606 wherein the software routine is capable of performing at least 100,000 distinct operations when executed.

5976. The method of aspect 606 wherein the software routine is capable of performing at least 1,000,000 distinct operations when executed.

5977. The method of aspect 653 wherein the software enterprise system is capable of performing at least 100,000 distinct operations when executed.

5978. The method of aspect 653 wherein the software enterprise system is capable of performing at least 1,000,000 distinct operations when executed.

5979. The method of aspect 653 wherein the software enterprise system is capable of performing at least 100 distinct operations when executed.

5980. The method of aspect 785 wherein the software program is capable of performing at least 1,000 distinct operations when executed.

5981. The method of aspect 785 wherein the software program is capable of performing at least 10,000 distinct operations when executed.

5982. The method of aspect 785 wherein the software program is capable of performing at least 100,000 distinct operations when executed.

5983. The method of aspect 785 wherein the software program is capable of performing at least 1,000,000 distinct operations when executed.

5984. The method of aspect 1168 wherein the software program is capable of performing at least 1,000 distinct operations when executed.

5985. The method of aspect 1168 wherein the software program is capable of performing at least 10,000 distinct operations when executed.

5986. The method of aspect 1168 wherein the software program is capable of performing at least 100,000 distinct operations when executed.

5987. The method of aspect 1168 wherein the software program is capable of performing at least 1,000,000 distinct operations when executed.

5988. The software enterprise system of aspect 2490, capable of performing at least 1,000 distinct operations when executed.

5989. The software enterprise system of aspect 2491, capable of performing at least 1,000 distinct operations when executed.

5990. The software enterprise system of aspect 2492, capable of performing at least 1,000 distinct operations when executed.

5991. The software enterprise system of aspect 2493, capable of performing at least 1,000 distinct operations when executed.

5992. The software enterprise system of aspect 2494, capable of performing at least 1,000 distinct operations when executed.

5993. The software enterprise system of aspect 2495, capable of performing at least 1,000 distinct operations when executed.

5994. The software enterprise system of aspect 2496, capable of performing at least 1,000 distinct operations when executed.

5995. The software enterprise system of aspect 2497, capable of performing at least 1,000 distinct operations when executed.

5996. The software enterprise system of aspect 2498, capable of performing at least 1,000 distinct operations when executed.

5998. The software enterprise system of aspect 2499, capable of performing at least 1,000 distinct operations when executed.

5999. The software enterprise system of aspect 2500, capable of performing at least 1,000 distinct operations when executed.

6000. The software enterprise system of aspect 2501, capable of performing at least 1,000 distinct operations when executed.

6001. The software enterprise system of aspect 2502, capable of performing at least 1,000 distinct operations when executed.

6002. The software enterprise system of aspect 2490, capable of performing at least 10,000 distinct operations when executed.

6003. The software enterprise system of aspect 2491, capable of performing at least 10,000 distinct operations when executed.

6004. The software enterprise system of aspect 2492, capable of performing at least 10,000 distinct operations when executed.

6005. The software enterprise system of aspect 2493, capable of performing at least 10,000 distinct operations when executed.

6006. The software enterprise system of aspect 2494, capable of performing at least 10,000 distinct operations when executed.

6007. The software enterprise system of aspect 2495, capable of performing at least 10,000 distinct operations when executed.

6008. The software enterprise system of aspect 2496, capable of performing at least 10,000 distinct operations when executed.

6009. The software enterprise system of aspect 2497, capable of performing at least 10,000 distinct operations when executed.

6010. The software enterprise system of aspect 2498, capable of performing at least 10,000 distinct operations when executed.

6011. The software enterprise system of aspect 2499, capable of performing at least 10,000 distinct operations when executed.

6012. The software enterprise system of aspect 2500, capable of performing at least 10,000 distinct operations when executed.

6013. The software enterprise system of aspect 2501, capable of performing at least 10,000 distinct operations when executed.

6014. The software enterprise system of aspect 2502, capable of performing at least 10,000 distinct operations when executed.

6015. The software enterprise system of aspect 2490, capable of performing at least 100,000 distinct operations when executed.

6016. The software enterprise system of aspect 2491, capable of performing at least 100,000 distinct operations when executed.

6017. The software enterprise system of aspect 2492, capable of performing at least 100,000 distinct operations when executed.

6018. The software enterprise system of aspect 2493, capable of performing at least 100,000 distinct operations when executed.

6019. The software enterprise system of aspect 2494, capable of performing at least 100,000 distinct operations when executed.

6020. The software enterprise system of aspect 2495, capable of performing at least 100,000 distinct operations when executed.

6021. The software enterprise system of aspect 2496, capable of performing at least 100,000 distinct operations when executed.

6022. The software enterprise system of aspect 2497, capable of performing at least 100,000 distinct operations when executed.

6023. The software enterprise system of aspect 2498, capable of performing at least 100,000 distinct operations when executed.

6024. The software enterprise system of aspect 2499, capable of performing at least 100,000 distinct operations when executed.

6025. The software enterprise system of aspect 2500, capable of performing at least 100,000 distinct operations when executed.

6026. The software enterprise system of aspect 2501, capable of performing at least 100,000 distinct operations when executed.

6027. The software enterprise system of aspect 2502, capable of performing at least 100,000 distinct operations when executed.

6028. The software enterprise system of aspect 2490, capable of performing at least 1,000,000 distinct operations when executed.

6029. The software enterprise system of aspect 2491, capable of performing at least 1,000,000 distinct operations when executed.

6030. The software enterprise system of aspect 2492, capable of performing at least 1,000,000 distinct operations when executed.

6031. The software enterprise system of aspect 2493, capable of performing at least 1,000,000 distinct operations when executed.

6032. The software enterprise system of aspect 2494, capable of performing at least 1,000,000 distinct operations when executed.

6033. The software enterprise system of aspect 2495, capable of performing at least 1,000,000 distinct operations when executed.

6034. The software enterprise system of aspect 2496, capable of performing at least 1,000,000 distinct operations when executed.

6035. The software enterprise system of aspect 2497, capable of performing at least 1,000,000 distinct operations when executed.

6036. The software enterprise system of aspect 2498, capable of performing at least 1,000,000 distinct operations when executed.

6037. The software enterprise system of aspect 2499, capable of performing at least 1,000,000 distinct operations when executed.

6038. The software enterprise system of aspect 2500, capable of performing at least 1,000,000 distinct operations when executed.

6039. The software enterprise system of aspect 2501, capable of performing at least 1,000,000 distinct operations when executed.

6040. The software enterprise system of aspect 2502, capable of performing at least 1,000,000 distinct operations when executed.

6041. The computer language of aspect 3391, wherein all programs comprise commercially useful programs capable of performing at least 1,000 distinct operations when executed.

6042. The computer language of aspect 3391, wherein all programs comprise programs capable of performing at least 1,000 distinct operations when executed.

6043. The computer language of aspect 3391, wherein all programs comprise commercially useful programs capable of performing at least 10,000 distinct operations when executed.

6044. The computer language of aspect 3391, wherein all programs comprise programs capable of performing at least 10,000 distinct operations when executed.

6045. The computer language of aspect 3391, wherein all programs comprise commercially useful programs capable of performing at least 100,000 distinct operations when executed.

6046. The computer language of aspect 3391, wherein all programs comprise programs capable of performing at least 100,000 distinct operations when executed.

6047. The computer language of aspect 3391, wherein all programs comprise commercially useful programs capable of performing at least 1,000,000 distinct operations when executed.

6048. The computer language of aspect 3391, wherein all programs comprise programs capable of performing at least 10,000,000 distinct operations when executed.

6049. The software module of aspect 4110, capable of performing at least 1,000 distinct operations when executed.

6050. The software module of aspect 4111, capable of performing at least 1,000 distinct operations when executed.

6051. The software module of aspect 4112, capable of performing at least 1,000 distinct operations when executed.

6052. The software module of aspect 4113, capable of performing at least 1,000 distinct operations when executed.

6053. The software module of aspect 4114, capable of performing at least 1,000 distinct operations when executed.

6054. The software module of aspect 4115, capable of performing at least 1,000 distinct operations when executed.

6055. The software module of aspect 4116, capable of performing at least 1,000 distinct operations when executed.

6056. The software module of aspect 4117, capable of performing at least 1,000 distinct operations when executed.

6057. The software module of aspect 4118, capable of performing at least 1,000 distinct operations when executed.

6058. The software module of aspect 4119, capable of performing at least 1,000 distinct operations when executed.

6059. The software module of aspect 4120, capable of performing at least 1,000 distinct operations when executed.

6060. The software module of aspect 4121, capable of performing at least 1,000 distinct operations when executed.

6061. The software module of aspect 4122, capable of performing at least 1,000 distinct operations when executed.

6062. The software module of aspect 4110, capable of performing at least 10,000 distinct operations when executed.

6063. The software module of aspect 4111, capable of performing at least 10,000 distinct operations when executed.

6064. The software module of aspect 4112, capable of performing at least 10,000 distinct operations when executed.

6065. The software module of aspect 4113, capable of performing at least 10,000 distinct operations when executed.

6066. The software module of aspect 4114, capable of performing at least 10,000 distinct operations when executed.

6067. The software module of aspect 4115, capable of performing at least 10,000 distinct operations when executed.

6068. The software module of aspect 4116, capable of performing at least 10,000 distinct operations when executed.

6069. The software module of aspect 4117, capable of performing at least 10,000 distinct operations when executed.

6070. The software module of aspect 4118, capable of performing at least 10,000 distinct operations when executed.

6071. The software module of aspect 4119, capable of performing at least 10,000 distinct operations when executed.

6072. The software module of aspect 4120, capable of performing at least 10,000 distinct operations when executed.

6073. The software module of aspect 4121, capable of performing at least 10,000 distinct operations when executed.

6074. The software module of aspect 4122, capable of performing at least 10,000 distinct operations when executed.

6075. The software module of aspect 4110, capable of performing at least 100,000 distinct operations when executed.

6076. The software module of aspect 4111, capable of performing at least 100,000 distinct operations when executed.

6077. The software module of aspect 4112, capable of performing at least 100,000 distinct operations when executed.

6078. The software module of aspect 4113, capable of performing at least 100,000 distinct operations when executed.

6079. The software module of aspect 4114, capable of performing at least 100,000 distinct operations when executed.

6080. The software module of aspect 4115, capable of performing at least 100,000 distinct operations when executed.

6081. The software module of aspect 4116, capable of performing at least 100,000 distinct operations when executed.

6082. The software module of aspect 4117, capable of performing at least 100,000 distinct operations when executed.

6083. The software module of aspect 4118, capable of performing at least 100,000 distinct operations when executed.

6084. The software module of aspect 4119, capable of performing at least 100,000 distinct operations when executed.

6085. The software module of aspect 4120, capable of performing at least 100,000 distinct operations when executed.

6086. The software module of aspect 4121, capable of performing at least 100,000 distinct operations when executed.

6087. The software module of aspect 4122, capable of performing at least 100,000 distinct operations when executed.

6088. The software module of aspect 4110, capable of performing at least 1,000,000 distinct operations when executed.

6089. The software module of aspect 4111, capable of performing at least 1,000,000 distinct operations when executed.

6090. The software module of aspect 4112, capable of performing at least 1,000,000 distinct operations when executed.

6091. The software module of aspect 4113, capable of performing at least 1,000,000 distinct operations when executed.

6092. The software module of aspect 4114, capable of performing at least 1,000,000 distinct operations when executed.

6093. The software module of aspect 4115, capable of performing at least 1,000,000 distinct operations when executed.

6094. The software module of aspect 4116, capable of performing at least 1,000,000 distinct operations when executed.

6095. The software module of aspect 4117, capable of performing at least 1,000,000 distinct operations when executed.

6096. The software module of aspect 4118, capable of performing at least 1,000,000 distinct operations when executed.

6097. The software module of aspect 4119, capable of performing at least 1,000,000 distinct operations when executed.

6098. The software module of aspect 4120, capable of performing at least 1,000,000 distinct operations when executed.

6099. The software module of aspect 4121, capable of performing at least 1,000,000 distinct operations when executed.

6100. The software module of aspect 4122, capable of performing at least 1,000,000 distinct operations when executed.

6101. The software procedure of aspect 4565, capable of performing at least 1,000 distinct operations when executed.

6102. The software procedure of aspect 4566, capable of performing at least 1,000 distinct operations when executed.

6103. The software procedure of aspect 4567, capable of performing at least 1,000 distinct operations when executed.

6104. The software procedure of aspect 4568, capable of performing at least 1,000 distinct operations when executed.

6105. The software procedure of aspect 4569, capable of performing at least 1,000 distinct operations when executed.

6106. The software procedure of aspect 4570, capable of performing at least 1,000 distinct operations when executed.

6107. The software procedure of aspect 4571, capable of performing at least 1,000 distinct operations when executed.

6108. The software procedure of aspect 4572, capable of performing at least 1,000 distinct operations when executed.

6109. The software procedure of aspect 4573, capable of performing at least 1,000 distinct operations when executed.

6110. The software procedure of aspect 4574, capable of performing at least 1,000 distinct operations when executed.

6111. The software procedure of aspect 4575, capable of performing at least 1,000 distinct operations when executed.

6112. The software procedure of aspect 4576, capable of performing at least 1,000 distinct operations when executed.

6113. The software procedure of aspect 4577, capable of performing at least 1,000 distinct operations when executed.

6114. The software procedure of aspect 4565, capable of performing at least 10,000 distinct operations when executed.

6115. The software procedure of aspect 4566, capable of performing at least 10,000 distinct operations when executed.

6116. The software procedure of aspect 4567, capable of performing at least 10,000 distinct operations when executed.

6117. The software procedure of aspect 4568, capable of performing at least 10,000 distinct operations when executed.

6118. The software procedure of aspect 4569, capable of performing at least 10,000 distinct operations when executed.

6119. The software procedure of aspect 4570, capable of performing at least 10,000 distinct operations when executed.

6120. The software procedure of aspect 4571, capable of performing at least 10,000 distinct operations when executed.

6121. The software procedure of aspect 4572, capable of performing at least 10,000 distinct operations when executed.

6122. The software procedure of aspect 4573, capable of performing at least 10,000 distinct operations when executed.

6123. The software procedure of aspect 4574, capable of performing at least 10,000 distinct operations when executed.

6124. The software procedure of aspect 4575, capable of performing at least 10,000 distinct operations when executed.

6125. The software procedure of aspect 4576, capable of performing at least 10,000 distinct operations when executed.

6126. The software procedure of aspect 4577, capable of performing at least 10,000 distinct operations when executed.

6127. The software procedure of aspect 4565, capable of performing at least 100,000 distinct operations when executed.

6128. The software procedure of aspect 4566, capable of performing at least 100,000 distinct operations when executed.

6129. The software procedure of aspect 4567, capable of performing at least 100,000 distinct operations when executed.

6130. The software procedure of aspect 4568, capable of performing at least 100,000 distinct operations when executed.

6131. The software procedure of aspect 4569, capable of performing at least 100,000 distinct operations when executed.

6132. The software procedure of aspect 4570, capable of performing at least 100,000 distinct operations when executed.

6133. The software procedure of aspect 4571, capable of performing at least 100,000 distinct operations when executed.

6134. The software procedure of aspect 4572, capable of performing at least 100,000 distinct operations when executed.

6135. The software procedure of aspect 4573, capable of performing at least 100,000 distinct operations when executed.

6136. The software procedure of aspect 4574, capable of performing at least 100,000 distinct operations when executed.

6137. The software procedure of aspect 4575, capable of performing at least 100,000 distinct operations when executed.

6138. The software procedure of aspect 4576, capable of performing at least 100,000 distinct operations when executed.

6139. The software procedure of aspect 4577, capable of performing at least 100,000 distinct operations when executed.

6140. The software procedure of aspect 4565, capable of performing at least 1,000,000 distinct operations when executed.

6141. The software procedure of aspect 4566, capable of performing at least 1,000,000 distinct operations when executed.

6142. The software procedure of aspect 4567, capable of performing at least 1,000,000 distinct operations when executed.

6143. The software procedure of aspect 4568, capable of performing at least 1,000,000 distinct operations when executed.

6144. The software procedure of aspect 4569, capable of performing at least 1,000,000 distinct operations when executed.

6145. The software procedure of aspect 4570, capable of performing at least 1,000,000 distinct operations when executed.

6146. The software procedure of aspect 4571, capable of performing at least 1,000,000 distinct operations when executed.

6147. The software procedure of aspect 4572, capable of performing at least 1,000,000 distinct operations when executed.

6148. The software procedure of aspect 4573, capable of performing at least 1,000,000 distinct operations when executed.

6149. The software procedure of aspect 4574, capable of performing at least 1,000,000 distinct operations when executed.

6150. The software procedure of aspect 4575, capable of performing at least 1,000,000 distinct operations when executed.

6151. The software procedure of aspect 4576, capable of performing at least 1,000,000 distinct operations when executed.

6152. The software procedure of aspect 4577, capable of performing at least 1,000,000 distinct operations when executed.

6153. The computer program of aspect 5020, capable of performing at least 1,000 distinct operations when executed.

6144. The computer program of aspect 5021, capable of performing at least 1,000 distinct operations when executed.

6145. The computer program of aspect 5022, capable of performing at least 1,000 distinct operations when executed.

6146. The computer program of aspect 5023, capable of performing at least 1,000 distinct operations when executed.

6147. The computer program of aspect 5024, capable of performing at least 1,000 distinct operations when executed.

6148. The computer program of aspect 5025, capable of performing at least 1,000 distinct operations when executed.

6149. The computer program of aspect 5026, capable of performing at least 1,000 distinct operations when executed.

6150. The computer program of aspect 5027, capable of performing at least 1,000 distinct operations when executed.

6151. The computer program of aspect 5028, capable of performing at least 1,000 distinct operations when executed.

6152. The computer program of aspect 5029, capable of performing at least 1,000 distinct operations when executed.

6153. The computer program of aspect 5030, capable of performing at least 1,000 distinct operations when executed.

6154. The computer program of aspect 5031, capable of performing at least 1,000 distinct operations when executed.

6155. The computer program of aspect 5032, capable of performing at least 1,000 distinct operations when executed.

6156. The computer program of aspect 5020, capable of performing at least 10,000 distinct operations when executed.

6157. The computer program of aspect 5021, capable of performing at least 10,000 distinct operations when executed.

6158. The computer program of aspect 5022, capable of performing at least 10,000 distinct operations when executed.

6159. The computer program of aspect 5023, capable of performing at least 10,000 distinct operations when executed.

6160. The computer program of aspect 5024, capable of performing at least 10,000 distinct operations when executed.

6161. The computer program of aspect 5025, capable of performing at least 10,000 distinct operations when executed.

6162. The computer program of aspect 5026, capable of performing at least 10,000 distinct operations when executed.

6163. The computer program of aspect 5027, capable of performing at least 10,000 distinct operations when executed.

6164. The computer program of aspect 5028, capable of performing at least 10,000 distinct operations when executed.

6165. The computer program of aspect 5029, capable of performing at least 10,000 distinct operations when executed.

6166. The computer program of aspect 5030, capable of performing at least 10,000 distinct operations when executed.

6167. The computer program of aspect 5031, capable of performing at least 10,000 distinct operations when executed.

6168. The computer program of aspect 5032, capable of performing at least 10,000 distinct operations when executed.

6169. The computer program of aspect 5020, capable of performing at least 100,000 distinct operations when executed.

6170. The computer program of aspect 5021, capable of performing at least 100,000 distinct operations when executed.

6171. The computer program of aspect 5022, capable of performing at least 100,000 distinct operations when executed.

6172. The computer program of aspect 5023, capable of performing at least 100,000 distinct operations when executed.

6173. The computer program of aspect 5024, capable of performing at least 100,000 distinct operations when executed.

6174. The computer program of aspect 5025, capable of performing at least 100,000 distinct operations when executed.

6175. The computer program of aspect 5026, capable of performing at least 100,000 distinct operations when executed.

6176. The computer program of aspect 5027, capable of performing at least 100,000 distinct operations when executed.

6177. The computer program of aspect 5028, capable of performing at least 100,000 distinct operations when executed.

6178. The computer program of aspect 5029, capable of performing at least 100,000 distinct operations when executed.

6179. The computer program of aspect 5030, capable of performing at least 100,000 distinct operations when executed.

6180. The computer program of aspect 5031, capable of performing at least 100,000 distinct operations when executed.

6181. The computer program of aspect 5032, capable of performing at least 100,000 distinct operations when executed.

6182. The computer program of aspect 5020, capable of performing at least 1,000,000 distinct operations when executed.

6183. The computer program of aspect 5021, capable of performing at least 1,000,000 distinct operations when executed.

6184. The computer program of aspect 5022, capable of performing at least 1,000,000 distinct operations when executed.

6185. The computer program of aspect 5023, capable of performing at least 1,000,000 distinct operations when executed.

6186. The computer program of aspect 5024, capable of performing at least 1,000,000 distinct operations when executed.

6187. The computer program of aspect 5025, capable of performing at least 1,000,000 distinct operations when executed.

6188. The computer program of aspect 5026, capable of performing at least 1,000,000 distinct operations when executed.

6189. The computer program of aspect 5027, capable of performing at least 1,000,000 distinct operations when executed.

6190. The computer program of aspect 5028, capable of performing at least 1,000,000 distinct operations when executed.

6191. The computer program of aspect 5029, capable of performing at least 1,000,000 distinct operations when executed.

6192. The computer program of aspect 5030, capable of performing at least 1,000,000 distinct operations when executed.

6193. The computer program of aspect 5031, capable of performing at least 1,000,000 distinct operations when executed.

6194. The computer program of aspect 5032, capable of performing at least 1,000,000 distinct operations when executed.

6195. Automatically determining a semantic difference between two portions of a program.

6196. Utilizing automated reasoning in conjunction with on or more finite input output semantic models to determine semantic equivalence between portions of computer code.

6197. Determining if a finite input output semantic model for a first portion of computer code is a semantic subset of a second portion of computer code.

6198. A method for automatically determining semantic equivalence between two portions of a program comprising:
generating a finite input output semantic model for a first portion of the program;
generating a finite input output semantic model for a second portion of the program; and
comparing the finite input output semantic model for the first portion of the program to the finite input output semantic model for the second portion of the program to determine if:
   the finite input output semantic model for the first portion of the program is a subset of the finite input output semantic model for the second portion of the program, and
   the finite input output semantic model for the second portion of the program is a subset of the finite input output semantic model for the first portion of the program.

6199. The method of aspect 6198 further comprising pattern matching one or more of enumerable and non-enumerable data types.

6200. A method of software quality assurance comprising analyzing one or more finite input output semantic models of a program.

6201. The method of aspect 6200, wherein the analyzing comprises a regression process.

6202. The method of aspect 6200, wherein the analyzing comprises determining policy compliance.

6202. The method of aspect 6201, wherein the regression process comprises:
determining a finite input output semantic model for a first portion of the program;
determining a subset of the finite input output semantic model, wherein the subset is one or more input/output pattern definitions; and
determining a finite input output semantic model for the one or more input/output pattern definitions.

6203. The method of aspect 6202, wherein a policy provides a constraint on input/output behavior of the program.

6204. The method of aspect 6203, wherein the policy has an input/output signature corresponding to the program it references.

6205. The method of aspect 6202, wherein policy creation comprises:
determining a policy to represent at least one user-defined policy, wherein the policy is a finite input output semantic model; and
storing the policy.

6206. The method of aspect 6201, further comprising testing the regression process including:
obtaining the finite input output semantic model for the program;
loading a regression set;
comparing the finite input output semantic model for the program and the regression set; and
determining whether the regression set is a subset of the finite input output semantic model for the program.

6207. The method of aspect 6202, wherein testing of policy compliance comprises:
obtaining the finite input output semantic model for the program;
loading a policy;
performing a comparison process to determine which input/output pattern definitions in the finite input output semantic model have input patterns which subsume an input pattern of a policy finite input output semantic model; and
performing a comparison process to determine which input/output patterns from the above comparison process are subsumed by an output pattern of the finite input output semantic model for the policy.

6208. A method of software quality assurance comprising analyzing one or more finite input output semantic models of a program in cooperation with a policy validation user interface.

6209. A method for analyzing a program comprising:
browsing, in a user interface, one or more portions of a semantic model of the program, wherein the user interface provides a tool for a user to perform one or more of policy testing and regression testing on the one or more portions of the semantic model.

These and other aspects, features and advantages of this invention are described in, or are apparent from, the following detailed description of the exemplary embodiments.

### BRIEF DESCRIPTION OF THE DRAWINGS

The exemplary embodiments of the invention will be described in detail, with reference to the following figures wherein:

Prior Art FIG. 1 is a diagram illustrating the average loss in programmer productivity as the complexity of a software development project increases.

Prior Art FIG. 2 is a diagram illustrating the average increase error rate of a programmer as the complexity of a software development project increases.

FIG. 3 illustrates an exemplary computer system upon which embodiments of the invention may be implemented.

FIG. 4 illustrates an exemplary network in which embodiments of the present invention may be implemented.

FIG. 5 is a block diagram illustrating the usage of a finite input output semantic model (FIOSM) in the development of enterprise software according to one embodiment of the present invention.

Prior Art FIG. 6 illustrates the typical operations performed by quality assurance (QA) in determining whether a newly developed or updated program is suitable for use.

FIG. 7 illustrates the QA operations eliminated by way of strike-throughs when a FIOSM QA process is utilized according to one embodiment of the present invention.

FIG. 8 is a flow chart primarily illustrating the design and verification processes relative to creating a FIOSM-compatible programming language according to one embodiment of the present invention.

FIG. 9 comprises a table of data constraint expression examples according to one embodiment of the present invention.

FIG. 10 is a table of Code data type examples according to one embodiment of the present invention.

FIG. 11 is a table of enumerable data constraint expression examples according to one embodiment of the present invention.

FIG. 12 is a set of an Input-Output Pattern of Data for an example program according to one embodiment of the present invention.

FIG. 13 is an exemplary format for an Input-Output Pattern of Data according to one embodiment of the present invention.

FIG. 14 is an example of an arbitrary direct graph according to one embodiment of the present invention.

FIGS. 15 & 16 illustrate examples of two program operators from the ioExample language according to one embodiment of the present invention.

FIG. 17 is another example of a directed acyclic graph according to one embodiment of the present invention.

FIG. 18 is an example of a source program variable and possible values of the variable according to one embodiment of the present invention.

FIG. 19 is an example of the possible values of source program variable transformed into data elements according to one embodiment of the present invention.

FIG. 20 is a flow chart illustrating the process of generating a FIOSM according to one embodiment of the present invention.

FIG. 21 is an illustration of source code from an example program transformed into a parse tree according to one embodiment of the present invention.

FIG. 22 is an illustration of a parse tree of the example program of FIG. 16 transformed into a Code Path Set according to one embodiment of the present invention.

FIG. 23 is an illustration of a Code Path Set of the example program of FIG. 16 transformed into a Path Data Model Set according to one embodiment of the present invention.

FIG. 24 is an illustration of a Code Path Set that results in a logically inconsistent data model when transformed according to one embodiment of the present invention.

FIG. 25 is an illustration of a Path Data Model Set of the example program of FIG. 16 transformed into a FIOSM according to one embodiment of the present invention.

FIGS. 26A-26D illustrate an example of a system “InterestRate.”

FIG. 27 illustrates an exemplary finite code path direct graph.

FIG. 28 illustrates two examples of program operators from the ioExample language.

FIG. 29 illustrates a directed acyclic graph.

FIG. 30 illustrates an exemplary model generation process.

FIG. 31 illustrates the graph structure of InterestRate.

FIG. 32 illustrates the graph structure of FunProduct.

FIG. 33 illustrates the graph structure of OtherProducts.

FIG. 34 illustrates the graph structure of PersonalProduct.

FIG. 35 illustrates the model generation parse process hierarchy.

FIG. 36 illustrates the exemplary process of creating a parsed system.

FIG. 37 illustrates an exemplary model generation parse procedure flow.

FIG. 38 illustrates an exemplary model generation parse argument list.

FIG. 39 illustrates an exemplary translate table process for model generation.

FIG. 40 illustrates an exemplary parse action table.

FIG. 41 illustrates an exemplary parse statement block process for model generation.

FIGS. 42A-42D illustrate the building of the parse tree for procedure FunProduct.

FIG. 43 illustrates the exemplary process Translate System.

FIG. 44 illustrates exemplary subroutine processes of Translate System in FIG. 43.

FIG. 45 illustrates the exemplary subroutine Substitute Data Elements.

FIG. 46 illustrates the exemplary subroutine Get Current Procedure Name.

FIG. 47 illustrates the exemplary subroutine Get Current Variable State.

FIG. 48 illustrates the exemplary subroutine Get Next Procedure Name.

FIG. 49 illustrates the exemplary subroutine Get Next Variable State.

FIG. 50 illustrates the exemplary subroutine Increment Variable State.

FIG. 51 illustrates the exemplary subroutine Negate Expression.

FIGS. 52A-52B illustrate the exemplary subroutine Statement Translate Table.

FIG. 53 illustrates the exemplary subroutine Add Variable.

FIGS. 54A-54C illustrate the exemplary subroutine Translate Assignment Expression.

FIGS. 55A-55B illustrate the exemplary subroutine Translate Conditional Statement.

FIG. 56 illustrates the exemplary subroutine Translate Procedure.

FIGS. 57A-57B illustrate the exemplary subroutine Translate Procedure Arguments.

FIG. 58 illustrates the exemplary subroutine Translate Program Statement.

FIG. 59 illustrates the exemplary subroutine Translate Return Statement.

FIG. 60 illustrates the exemplary subroutine Translate Statement Block.

FIGS. 61-128F illustrate an example of the translation process.

FIGS. 129A-129B illustrate the exemplary Translate Generate All Patterns for the Tableau process.

FIG. 130 illustrates an overview of the subroutines for the Translate Generate All Patterns process.

FIG. 131 illustrates an example of the Allocate Code Instance subroutine.

FIG. 132 illustrates an example of the Allocate Numeric Instance subroutine.

FIG. 133 illustrates an example of the Allocate Procedure instance subroutine.

FIGS. 134A-134B illustrate an example of the Bind Code Instances subroutine.

FIGS. 135A-135B illustrate an example of the Bind Numeric Instances subroutine.

FIG. 136 illustrates an example of the Clone Model Container subroutine.

FIG. 137 illustrates an example of the Bind Code Return subroutine.

FIG. 138 illustrates an example of the Bind Numeric Return subroutine.

FIG. 139 illustrates an example of the Get Integer Association subroutine.

FIG. 140 illustrates an example of the Generate Pattern Model subroutine.

FIGS. 141A-141B illustrate an example of the pattern model generation table.

FIG. 142 illustrates an example of the Is Model Valid subroutine.

FIG. 143 illustrates an example of the Pop Procedure marker subroutine.

FIG. 144 illustrates an example of the Tableau Push Procedure Marker subroutine.

FIG. 145 illustrates an example of the Replace Code Literals subroutine.

FIGS. 146A-146OB, 175-176B, 178-179B, 181-182B, and 184-192B illustrate the state of the exemplary Model Container as the processes modify the container.

FIGS. 147A-174, 177A-177E, 180 and 183 illustrate the Term-Queues referenced in the Model Container diagrams.

FIGS. 193-197 illustrate the exemplary Model Generator diagrams that represent the state of the Model Generator as the processes modify the generator.

FIG. 198 illustrates an example of a method for testing the consistency of a system.

FIGS. 199A-199B illustrate an example of the Consistency process operation.

FIGS. 200A-200B illustrate an example of the consistency process operation for an inconsistent example.

FIG. 201 outlines an exemplary method for the Projection Process.

FIGS. 202A-202B illustrate an example of the projection process.

FIGS. 203A-203B illustrate an exemplary method of Eliminating Variables.

FIG. 204 illustrates an example of the elimination of variables process.

FIGS. 205A-205B illustrate an exemplary methodology of the combine to eliminate process.

FIG. 206 illustrates an example of the Combine To Eliminate process.

FIG. 207 illustrates an exemplary method of combining two expressions.

FIG. 208 illustrates an example of an operational chart for the combining of two expressions.

FIG. 209 illustrates an example of the Combine Two Expressions process.

FIG. 210 illustrates an exemplary method for the Normalize By process.

FIG. 211 illustrates an example of the Normalize By process.

FIG. 212 illustrates an exemplary method for Testing Literal Expressions.

FIG. 213 illustrates an example of the Testing Literal Expressions process.

FIG. 214 illustrates an exemplary method for Get All Variables.

FIG. 215 illustrates an example of the Get All Variables process.

FIGS. 216A-216B illustrate an exemplary translation method Format Model.

FIG. 217 illustrates an overview of the Format Model process.

FIG. 218 illustrates the exemplary Find Input Elements subroutine.

FIG. 219 illustrates the exemplary Find Output Element subroutine.

FIGS. 220A-220C illustrate the exemplary Pattern Model Input subroutine.

FIGS. 221A-221D illustrate the exemplary Pattern Model Output subroutine.

FIG. 222 illustrates an example of the Trim Variable subroutine.

FIGS. 223A-223B illustrate an exemplary Finite Input Output Semantic Model.

FIG. 224 illustrates a high level example of the relationship between the FIOSM, comparison and reasoning.

FIGS. 225A-225B illustrate an example of the comparison between desk debugging and automated reasoning.

FIG. 226 illustrates en exemplary high level semantic comparison methodology.

FIG. 227 illustrates an example of numeric data element subset testing methodology.

FIG. 228 illustrates an example of a method for IOPD pattern subset comparison.

FIG. 229 illustrates an exemplary regression process methodology.

FIG. 230 illustrates an exemplary methodology for policy creation.

FIG. 231 illustrates an exemplary methodology for regression testing.

FIG. 232 illustrates and exemplary methodology for policy testing.

FIGS. 233-240 illustrate various exemplary user interfaces associated with an exemplary software quality assurance example.

### DETAILED DESCRIPTION

Exemplary embodiments of the present invention comprise the processes of: (i) designing and verifying that a computer language can completely and correctly generate a Finite Input-Output Semantic Model (FIOSM); and (ii) generating, typically using automation, a FIOSM for a program or system of several programs written in a FIOSM-compatible language. Additional exemplary embodiments include comparison of FIOSM's and software quality assurance techniques.

The two processes for the designing and generating of the FIOSM are connected by the computer source language, and the algorithms used in both processes. This disclosure both defines and describes embodiments of each process in detail and specifies how they are connected. Integral to these processes is the FIOSM product, which is described in detail below, and illustrated in the in depth example provided in a later section.

The economic value of being able to automatically (via computer) generate a FIOSM for any arbitrary computer program written in a computer language is potentially enormous. It enables an unprecedented level of automation of software engineering activities. This automation promises in an equally unprecedented increase in both productivity and quality in medium to large software development projects. These size projects represent the majority of the economic activity associated with software development in science and industry.

The ability both to generate a FIOSM, and to achieve the resulting economic benefits of automation, cannot be accomplished with the computer languages in current mainstream use. Embodiments of the present invention provide a process for modifying those languages to achieve the benefits of FIOSM-based automation. Accordingly, embodiments describe the family of modified languages, and show how the FIOSM can be generated to achieve the consequent economic benefits.

The FIOSM design and generation processes provide not only immediate practical value, but further, in a practical manner, circumvent a theoretical limitation to automated software analysis that was identified in the first half of the twentieth century. Universal acceptance of this proof on the nature of algorithms (called the Turing “Halting Problem”) has heretofore arrested research into practical methods of automation of computer software development.

Accordingly, the embodiments of the ioSemantics tools, systems and methods provide not only the ability to generate a FIOSM for software programs, routines, procedures and the like but also provide for comparison techniques applied to FIOSMs (Semantic Models) that result in enhanced automated reasoning capabilities permit automation of software development processes that to date have been practically impossible to automate.

Reasoning operation Embodiments utilizing the FIOSM are based on the ability to determine a subset relationship between inputs and outputs of two different programs, or fragments of programs. The ability to determine subset relationships between sets is referred to as a “Subsumption Operation” in mathematical logic and ontology (reference: Handbook of Description Logic, which is included by reference in its entirety). In the context of software comparison, the process is simply referred to as “Comparison.”

These reasoning capabilities can be used in relation to Quality Assurance (QA) to more completely, more efficiently and more accurately verify proper operation of a new piece of software as is taught in certain embodiments of the present invention.

Essentially, the innovations described in the various embodiments permit software designers and their teams to generate useful programs, such as those having use in business including operations, inventory and finance, that can perform significant numbers of computations and operations, and know the exact behavior of the program with certainty. Accordingly, QA processes become much simpler and less expensive obviating the need for large QA test programs to determine the probable behavior of a program or system when subjected to data input variations. While the embodiments described herein are applicable to software procedures, routines, modules, programs and enterprise systems of all sizes, they offer the greatest benefit to larger complex procedures, routines, modules, programs and enterprise systems that are capable of performing preferably 1,000 or more operations, more preferably 10,000 or more operations, even more preferably 100,000 or more operations, and most preferably 1,000,000 or more operations. These useful programs are differentiated over simple and small software procedures, routines, modules and programs that automate simple singular operations or small combinations of operations that our often easy for a person to compute mentally without great difficulty. Such simple and small software procedures, routines, modules and programs are typically utilized to demonstrate the functionality of computers and software and are rarely used in business settings. As described herein, software procedures, routines, modules, programs and enterprise systems either (i) embodying aspects of the present invention or (ii) having been produced utilizing one or more embodiments typically comprise 1,000 or more lines of code, more often 10,000 or more lines of code, and in many instances over 100,000 and even 1,000,000 lines of code.

Many of the various embodiments described and claimed herein require that a finite input output model or FIOSM can be created from a computer language, a computer program, a computer system, a computer routine, and other related or similar computer procedures. Some of the specific properties and characteristics exhibited by these FIOSM-compatible computer procedures include, but are not necessarily limited to: (i) completely decidable dataflow; (ii) a finite code path; and (iii) a complete set of operators wherein no operator of the set is capable of invoking an infinite code path either by itself or in combination with other operators and no operator of the set has ambiguous semantics.

It is contemplated that code or portions of code could be developed that are outside of the principal operation or main business objective of a portion of a FIOSM compliant computer program, and the intent of this code or portion of code is to avoid FIOSM compatibility. However, any such code or portion of code may not affect the underlying FIOSM compliance of the computer program, and it is believed that the computer program with the code or portion of code would be literally if not equivalently the same as a program not having the code or portion of code.

For example, it is appreciated that variations of computer procedures can likely be created wherein one or more dummy operators or other code are inserted in the computer procedure that are capable alone or in combination with other dummy operators of invoking a infinite code path. Accordingly, an FIOSM for the procedure as a whole can not be created. For instance, the tree model of the procedure would have a branch or two containing these dummy operators that is not finite. However, it is speculated that the particular infinite branch is ancillary to the intended purpose of the procedure such that it does not directly affect the proper operation of the procedure. For instance, the infinite branch may be called only when a certain input is provided, such as a generally secret combination of keystrokes, that is not intended to be invoked during normal use of the procedure. Rather, the only purpose of the dummy operators and the resultant infinite branch may be to technically design around the claims as provided herein.

It is the position of the inventor that employing dummy operators with a computer procedure that is otherwise capable of generating an FIOSM in such a manner that the operators or any infinite branch that may be created by the operators do not affect the intended purpose of the computer procedure do not remove the remainder of the procedure outside the scope of the applicable claims provided herein either literally or in terms of equivalence. For instance, a computer language that includes one or more dummy operators that can alone or in combination invoke infinite code paths but wherein other operators that can effectively provide the same or substantially similar functionality without invoking an infinite code path are also provided and wherein instructions are provided directing programmers not to use the dummy operators, than the computer language would be literally if not equivalently the same as a language not having the dummy operators.

Further, it is conceivable that a programmer of a routine, program and/or enterprise system would be directed to design into the code a branch that is not finite, but wherein the branch is immaterial to the operation of the program being inaccessible or extremely difficult to access and having no specific relevance in relation to the intended operation of the routine, program and/or enterprise system. Rather, the purpose of adding a branch that is not finite would be in an attempt to design around one or more claims provided herein. In effect; however, any such routine, program, enterprise system or other computer procedure would be literally and equivalently the same as one or more embodiments described and claimed herein.

One of the potential effects of the embodiments described herein is to introduce a discontinuous innovation into the software development industry that has the potential to have global economic consequences. For example, embodiments of the present invention have the potential to reduce and even potentially nullify the labor cost advantage of moving software development overseas to lower cost labor market countries. Specifically, the increase in productivity realized by automation of software engineering activities as a result of the FIOSM offers to reduce the labor cost of development to such a degree that the potential savings from using inexpensive foreign labor becomes potentially insignificant.

Computer Science Historical Context

In essence, embodiments described herein disclose processes of identifying and creating a family of computer languages that can generate FIOSMs, as well as, processes for automated FIOSM generation for any program in the family. In the prior art, no one ever has characterized languages relative to their capability to generate a FIOSM.

In 1936, British mathematician Alan Turing demonstrated that so-called Universal Machines, corresponding to general programming languages, were beyond automated analysis. The essence of the proof was that with Universal Machines (equivalently, general computing languages) one could always identify at least one program for which the mathematical semantics was ambiguous. In the language of laymen: one could not determine what was the exact function of the program for all situations.

Embodiments of the processes described in this disclosure define and identify a family of programming languages that are practically suited to industry and science, that also circumvent the so-call Turing “Halting Problem” barrier, and that have unambiguous semantics, or in the language of mathematics: decidable semantics.

Embodiments described herein modify the program operators of machines/computers and prior art programming languages so that the corresponding programs always have precisely defined mathematical semantics. In the language of laymen, with any FIOSM-compatible computer language, you always know exactly what the corresponding programs do. In fact, the FIOSM itself is a precise mathematical model of the program's behavior.

Applying prior art methodology and programming languages, the barrier to automation in software development processes has in fact been equivalent to the Turing “Halting Problem” barrier. Prior to the identification of FIOSM-compatible computer languages as provided by embodiments disclosed herein, it would have been a fool's errand to try to build any sort of tools based on automated analysis of software. Turing had shown that algorithms themselves, or equivalently, computer programs, or more precisely Universal Machines, were beyond algorithmic analysis. This disclosure and the embodiments described herein open a path to enabling systems developed for industry and science to be analyzed precisely by other software systems as is discussed and described herein.

Definition of a FIOSM

As indicated above in the terminology section, Finite Input Output Semantic Model (FIOSM) defines the semantics of a program by precisely defining the patterns of input and output of data.

The mathematical definition of the word “semantics” is “meaning.” The “meaning” of a computer program is how it transforms information or data. The transformation of data is also referred to as a program's “behavior,” that is to say, what actions it takes. Throughout this filing, the words “semantics,” “meaning,” and “behavior,” when applied to computer programs, refer to the same concept, namely; what a computer program does.

A FIOSM describes behavior in terms of a set of input-output data patterns. This set is comprised members, which are individual patterns. Each member pattern is comprised of a set of input data expressions that define the valid values for input data elements, and a set of output data expressions that define the corresponding values for output data elements. The pattern says that for the corresponding program, if the input data elements satisfy the input expressions, then output of the program will be described by the output expressions. In totality, all the patterns in the FIOSM set describe the complete behavior of the program. In short: if the input pattern is true, then the output pattern is also true. The precise definition of an input-output pattern is discussed at length below.

The FIOSM is a set of input and output patterns. In addition, an FIOSM set has the quality of mathematical completeness and correctness. “Completeness” is the quality that says that the FIOSM includes every pattern of input-output that exists in the corresponding program. Alternatively stated: an FIOSM entirely describes the behavior of the corresponding program. “Correctness” is the quality that says every pattern is valid and there is no pattern that does not correspond to the behavior of the corresponding program. An alternative statement of this would be that there is no additional pattern that describes behavior beyond that of the corresponding program.

The FIOSM set must be finite. If the set is not finite, then the consequence will be ambiguity, or lack of clarity of meaning and behavior. If one wanted to determine the behavior of a program by asking “does this input-output pattern exist?” and the set of the patterns were infinite, then there would be no method to reliably answer the question.

Since any data element in a computer system can be considered input or output, one of the key considerations in generating an FIOSM is to being able to determine the value of every data element in a computer system, regardless of the code's execution path. In computer science terms, this is referred to as “decidable data flow.” The problem of determining the decidability of data flow is discussed at length in the below.

FIOSM Context, Automation and Productivity

In embodiments of the invention, the FIOSM does not replace the current process for compiling computer source programs into executable systems. Rather, it enhances the process by creating a model of the behavior of the system. This model is the FIOSM itself and it can be used in embodiments to automate previously manual processes associated with software engineering, such as but not limited to system verification, quality assurance processes, data modeling, data model creation and object design creation.

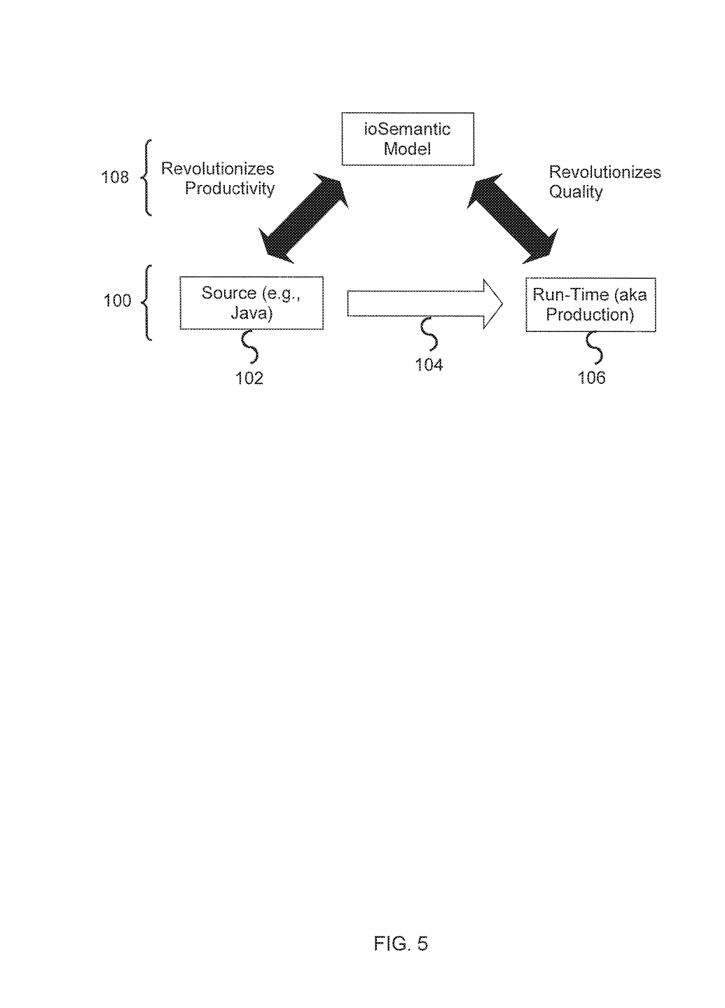

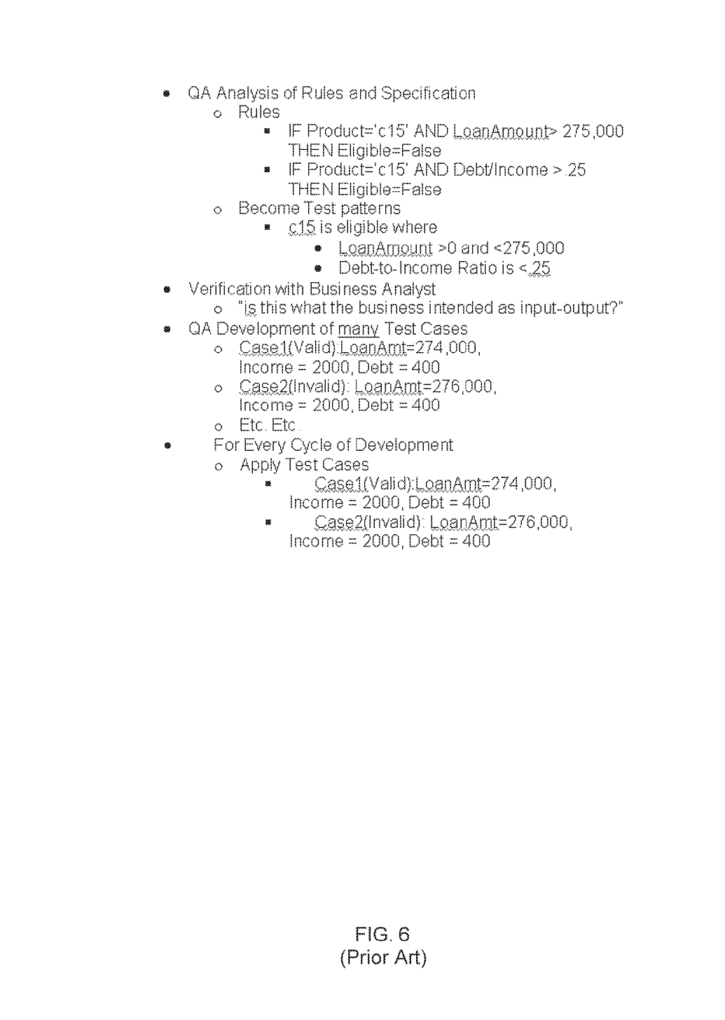

FIG. 5 graphically illustrates the relationship between existing processes in software creation and the FIOSM according to at least one embodiment of the present invention. The bottom section 100 illustrates the prior art or existing processes used by the software industry for developing software. Software 102 is coded in some source language, such as Java, and a compiler 104 transforms it into an executable form 106 that can be put into operation in a computer. This compiler process has been state of the art for 40 years. The FIOSM is an entirely new construct as illustrated in the top section 200, which is compatible with the existing compiling process, yet enhances the creation of software through automation and quality assurance.

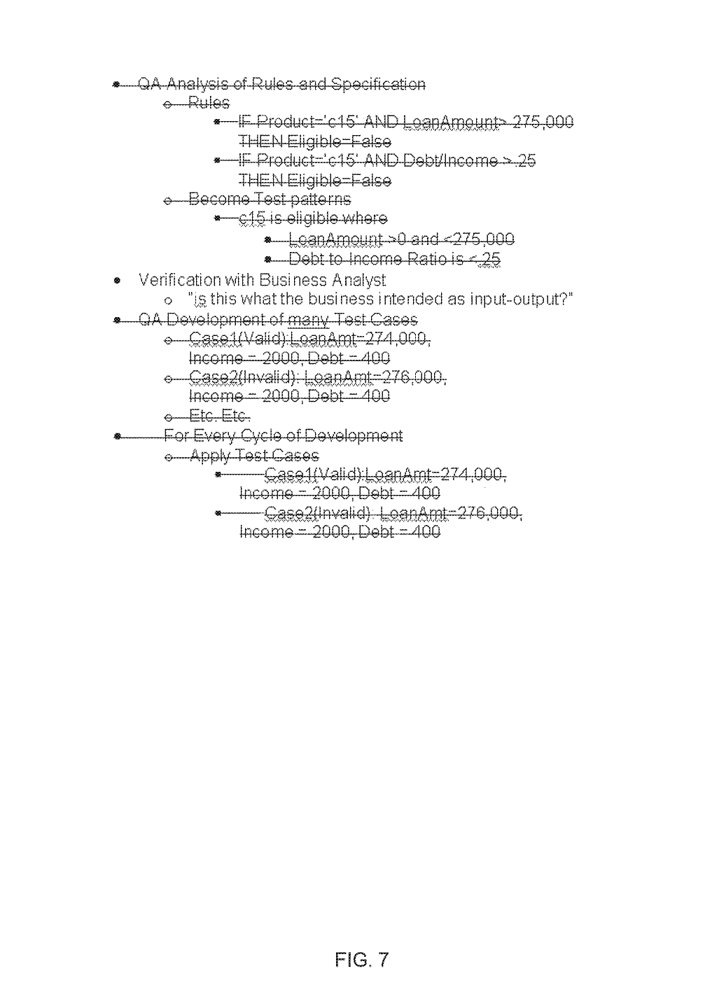

FIGS. 6 & 7 in sequence illustrate the effect of using a FIOSM on the software engineering process of quality assurance. FIG. 6 illustrates a brief example of steps or procedures involved in the QA (quality assurance) process for a hypothetical prior art rule-based system project, which involves the generation and running of numerous test cases to determine whether a system behaves as expected or desired. FIG. 7 shows the effect of using embodiments of the present invention that are FIOSM-based on quality assurance; the operations with the strike-throughs are either fully automated or not required. For instance, the generation and running of test cases is not required as the FIOSM provides each and every input and output pattern for the system. Since the generation of the FIOSM is typically fully automated, the labor required to generate and analyze the results of the test cases as under the prior art are is eliminated.

Using traditional QA processes applied to large and complex industry and governmental enterprise systems generated using traditional computer languages, no enterprise or developer can say with certainty “I know what my systems do” no matter the number of test cases generated, run and analyzed. Knowledge of the system's Input Output Semantics is approximate, and, therefore, knowledge of the system's quality is also approximate. With embodiments using a FIOSM, perfect quality can be assured because the entire behavior of the program is described by the FIOSM in contrast to the standard quality assurance processes, which only empirically approximate the behavior of a program. This productivity accomplishment alone promises enormous benefit relative to software projects in science and industry.

The effect on quality and quality assurance from using FIOSM-based embodiments is only an example of the potential benefits of using a FIOSM, yet it provides a fundamental foundation upon which additional improvements can be developed. Many expensive and critical activities in software engineering can be automated using the FIOSM-based embodiments described herein.

Language and the Generation of a FIOSM The generation of a FIOSM and its consequent benefits is ideally determined by the design of a computer language used therewith, and not subject to the specifics of any particular program written in the language. The semantics of the program operators, or equivalently, types of statements, that comprise a computer language determine the feasibility of a language being able to generate a FIOSM.

It is important to emphasize that the ability to create a semantic model is not a matter of superficial syntax, or a particular vendor's language products. Both Java (used extensively and promoted by IBM Corporation) and C# (produced by Microsoft Corporation) are distinct computer languages. Both in the entirety of their definitions are incompatible with the generation of a FIOSM. However, both can be modified by changing the allowed program operators to be able to generate FIOSMs. In fact, even with the modification, they could use the same compilers as are in current use (See FIG. 5). Embodiments of the present invention can be applied to most if not all existing languages and infrastructure. Some languages amenable to modification include, but are not limited to, C®, C+®, C++®, Java®, Basic©, Pascal© and Fortran©. Companies need not necessarily discard their investment nor start with wholly new computer languages.

Further, the visual display of the language is entirely irrelevant in embodiments of the invention. The language could be displayed to the programmer as text, a visual graph, a spreadsheet, and/or myriads of superficially different displays. What is centrally important are the types and semantics of the constituent program operators.

This disclosure and the embodiments described herein facilitate and enables the design of FIOSM compatible languages and FIOSM generators. The reasons for this are practical: a single generator for all possible programs that could be written in a computer language has the most benefit for the least effort. It also provides software developers the confidence that their automation tools will work regardless of how the programmers use a compatible computer language.

However, variations of the embodiments described herein can also be used to create a FIOSM for a single program. The process would be almost precisely the same as is described below except the process would only have to consider the types of program operators that comprise the program, as opposed to all the operators within the language in which the program is written. In other words, any language constructs not used in the program would not need to be considered.

The various embodiments and variations thereof illustrated in the accompanying Figures and/or described herein are merely exemplary and are not meant to limit the scope of the invention. It is to be appreciated that numerous variations of the invention have been contemplated as would be obvious to one of ordinary skill in the art with the benefit of this disclosure. Rather, the scope and breadth afforded this document should only be limited by the claims provided herein while applying either the plain meaning to each of the terms and phrases in the claims or the meaning clearly and unambiguously provided in this specification.

Terminology

The terms and phrases as indicated in parenthesis (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, and to the singular and plural variations of the defined word or phrase.

The term “or” as used in this specification and the appended claims is not meant to be exclusive rather the term is inclusive meaning “either or both”.

References in the herein to “one embodiment”, “an embodiment”, “a preferred embodiment”, “an alternative embodiment”, “embodiments”, “variations”, “a variation” and similar phrases means that a particular feature, structure, or characteristic described in connection with the embodiment(s) or variation(s) is included in at least an embodiment or variation of the invention. For instance, the appearances of the phrase “in one embodiment” or “in one variation” in various places in the specification are not necessarily all referring to the same embodiment or variation.

An “algorithm” is defined by the common Computer Science definition of algorithm; a procedural statement of steps and/or operations that transform input data into output data.

“Algorithmic behavior” is defined as the composition of input data values, and the resulting output data values generated by the algorithm.

Given a set of data expressions, a “consistent set of values” is another set of data expressions where there is a one-to-one correspondence between the data elements in the first set, with those of the second set. For each corresponding pair, the member of the “consistent set” is determined to be logically and operational consistent when evaluated under the rules of the data type.

A “computer” is defined as a device, module or a machine designed to execute programs.

A “data expression” is composed of a data element assigned either a data value or constrained to a set of values consistent with its data element's data type.

A “data element” is a uniquely named unit of information representing an object or concept in the world, with a specific defined data type.

A “data type” is an elemental category of data that is used to categorize data elements, and is used to define the permissible operations on them, and the set of possible values. Examples are, but not limited to, numeric, floating point, string, a code, etc.

A “data value” is a symbolic value from a set of all possible values. The set of values is determined by the corresponding data element's data type. A data value may be expressed as a literal value (i.e. a member of the permissible set) or as a result of an operation on other data.

An “enterprise system” is defined by its common definition in the Information Technology industry. Typically, it comprises a plurality of interrelated programs that provide functionality concerning the operation of a company or institution.

An “expression” is defined by its common mathematical definition; typically, it is a formula in a formal mathematical language.

An “FIOSM generator” as used herein is an automated process that accepts the source of computer program as input, and produces a FIOSM as output. Typically, FIOSM generators are constructed for specific computer language and the designed to accommodate any program written in that language.

“Formal logic” is defined by its common definition in Computer Science and Mathematical Logic.

“Grammar” is defined to mean its common meaning in Computer Science. Typically, a grammar defines how the various syntactic elements of a programming language may be combined into larger and more complex source language structures.

“Input data” is a set of data expressions passed into a program or program procedure. This is irrespective of the origin of the data, whether a terminal keyboard or a database repository, or some other source.

An “input-output pattern of data expression”, input-output pattern” or “input-output data pattern” is composed of a set where the members of the set are composed of one or more expressions of input data, and one or more one data expressions of output data. In both the case of input data and that of output data, there is a one-to-one correspondence to the input data and output data of the corresponding computer language source.

An “finite input-output semantic model” (also “FIOSM”) is a finite set of input-output patterns of data expressions that define the algorithmic behavior of a computer program, or program procedure. An input-output semantic model is both mathematically complete and mathematically correct, meaning that it lists all possible members of the finite set of input-output patterns of data expressions. And, each member is a valid definition of the behavior of the corresponding program or program procedure.

“Lexical content” is defined by its common meaning in Computer Science.

A “machine”, “general purpose computing machine” and “computing machine” all comprise one or more computing devices and/or software capable of executing a series of instructions i.e. a program.

A “module” is defined by its common definition in Computer Science.

An “operator” as used herein in computer languages is defined as a computational action that tests or modifies one or more data elements. Typically, specific operators are associated with specific data types.

“Output data” is a set of data expressions correspond to the output data from the program or program procedure. This is irrespective of the final destination of the output, whether a terminal screen or a database repository, or some other destination.

A “program” is defined by its common definition in Computer Science. Typically it is a series of instructions written in a language and instantiated in a computer to perform an algorithm.

A “program procedure” or “procedure” is defined by the common definition in Computer Science; it is a subsection of program that stands-alone in terms of accepting input data arguments, performing an algorithm using those arguments, and generating output data values.

A “reasoning service” is defined as a program that applies algorithms to the Input-Output Semantic Model to provide practical useful analysis of program function.

“Recursion” as used herein refers to an operation which includes a reference to itself.

A “routine” is defined by its common definition in Computer Science. Typically, it comprises a section of a program that performs a particular task.

“Semantic” is defined by its common definition in mathematical logic.

A “set” is the common mathematical definition: a non-redundant unordered collection of elements.

A “software system” is defined by the commonly understood definition in the Information Technology industry, typically a collection of programs that serve a useful business purpose. Alternatively, a “computer system” comprises one or more computer and as necessary related component s and peripherals. A “computer system” may or may not include software resident in the system's memory or storage.

A “source language”, “computer language”, “software language” and “programming language” as used herein is any computer language that has the capability to enable programs written in the language to algorithmically access and modify an arbitrary number of data elements.

A “variable” is the commonly understood usage in Computer Science.

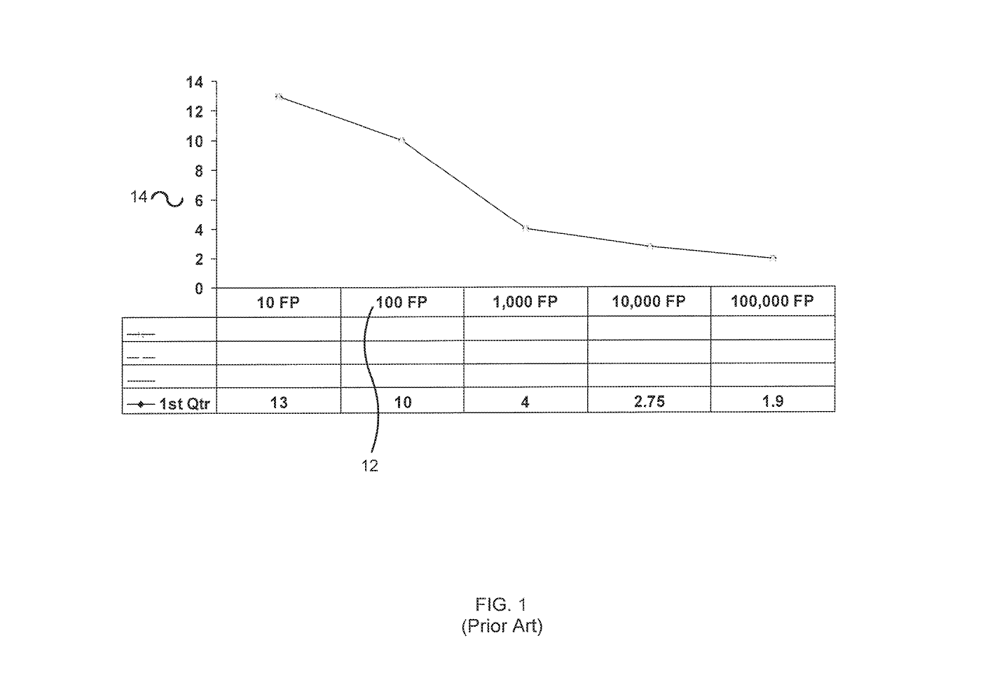

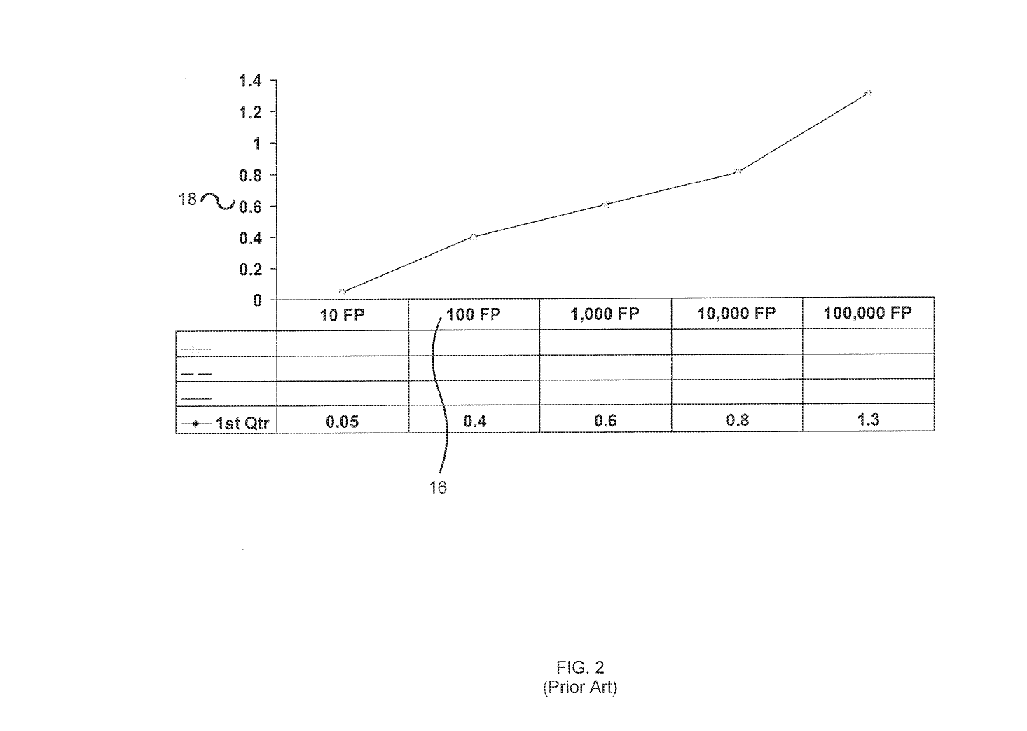

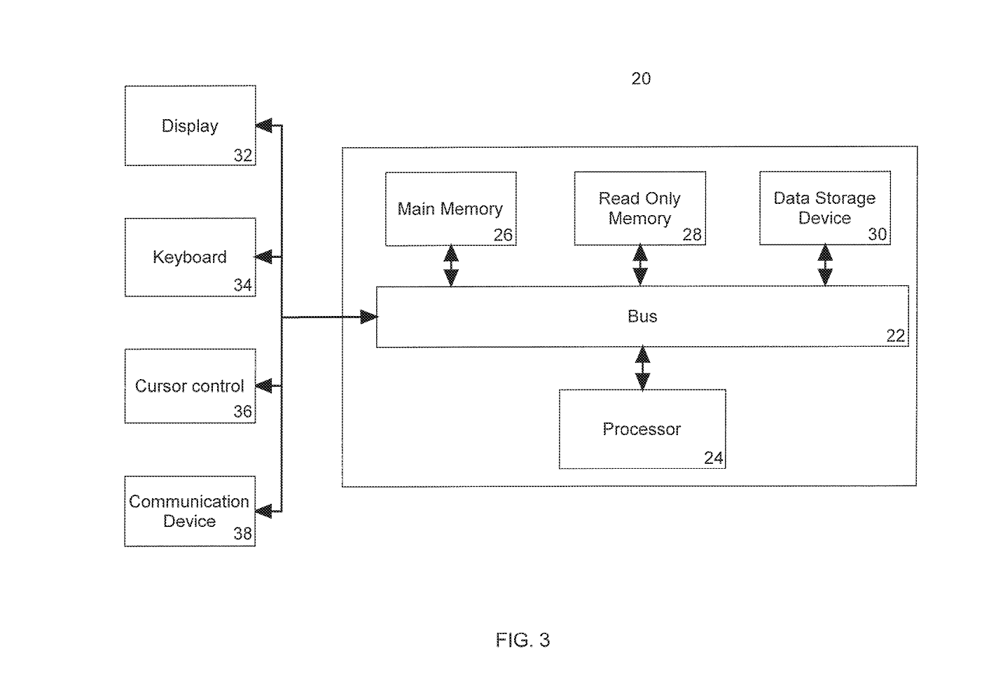

“Verification” is that process of assuring quality in a program or software system. Typically in the Information technology Industry this process is called Quality Assurance (QA). FIG. 3 illustrates an exemplary computer system 20 upon which embodiments of the invention may be implemented. The computer system can be alone or in a network to implement the processes and operations described herein.

The computer system typically comprises a bus 22 or other communication means for communicating information, and a processing means, such as a processor 24, coupled with the bus for processing information. The computer system further comprises a random access memory (RAM) or other dynamically-generated storage device 26 (referred to as main memory), coupled to the bus for storing information and instructions to be executed on by the processor. The main memory 26 may also be used for storing temporary variables or other intermediate information during execution of instructions by the processor. The computer system also typically comprises read only memory (ROM) 28 and/or another static storage device coupled to the bus 22 for storing static information and instructions for the processor. A data storage device 30, such as a magnetic disk or optical disk and its corresponding drive or a flash memory storage device may also be coupled to the computer system 20 for storing information and instructions. The computer system can also be coupled via the bus 22 to a display device 32, such as a cathode ray tube (CRT) or Liquid Crystal Display (LCD), for displaying information to an end user. Typically, an alphanumeric input device (keyboard) 34, including alphanumeric and other keys, may be coupled to the bus for communicating information and/or command selections to the processor 24. Another common type of user input device is cursor control device 36, such as a mouse, a trackball, a trackpad or cursor direction keys for communicating direction information and command selections to the processor and for controlling cursor movement on the display.

A communication device 38 is also coupled to the bus 22. The communication device may include a modem, a network interface card, or other well-known interface devices, such as those used for coupling to Ethernet, token ring, or other types of physical attachment for purposes of providing a communication link to support a local or wide area network, for example. The communications device may also be a wireless device for coupling to a wireless network.

The computer system can also include one or more hardware and/or software systems, such as FIOSM module(s), comparison module(s), subsumption module(s) and quality module(s) that implement one or more of the processes described herein.

It is appreciated that a lesser or more equipped computer system than the example described above may be desirable for certain implementations. Therefore, the configuration of computer system 20 will vary from implementation to implementation depending upon numerous factors, such as its intended use, price constraints, performance requirements, technological improvements, and/or other circumstances.

It should be noted that while the embodiments and methods described herein may be performed and used with a computer similar to the one described herein, other embodiments and variations can be used with computer that vary from the described example. Therefore, nothing disclosed herein concerning the configuration of the illustrated computer should be construed as limiting the present invention to a particular embodiment wherein the recited operations are performed by a specific combination of hardware components.

An Exemplary Network

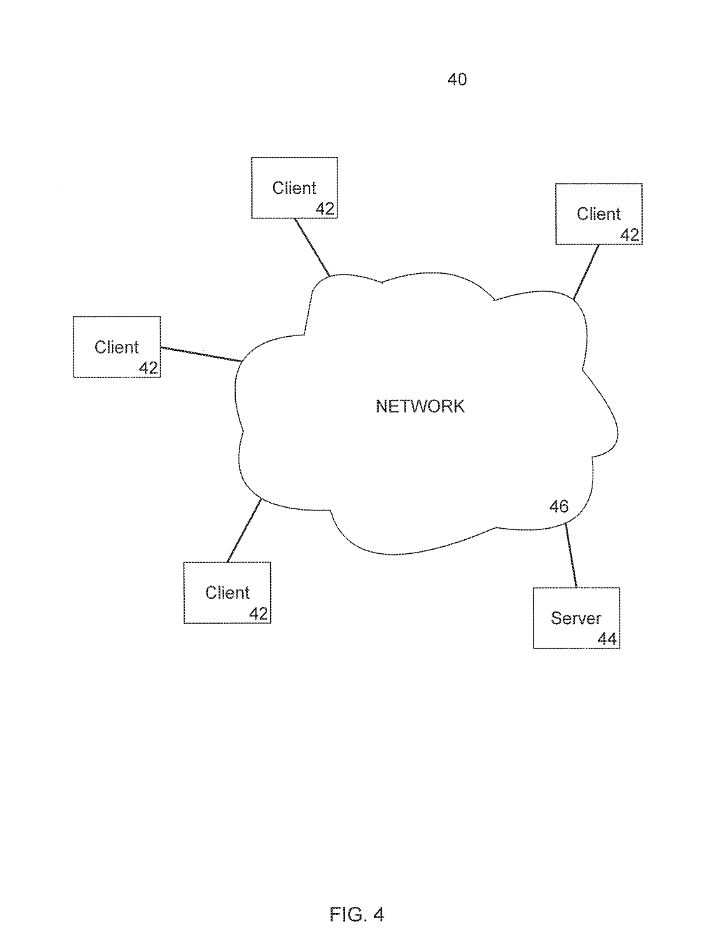

FIG. 4 illustrates an exemplary network 40 in which embodiments of the present invention may be implemented. Simply, the network comprises client computers 42 and one or more server computer(s) 44 that are interconnected through a suitable network connection 46, such as a secure or unsecured wired or wireless network, or some combination thereof, the Internet or an intranet, LAN, WAN etc. Both the server and client computers can be similar to the computer system described above concerning FIG. 3.

Depending on the embodiment, the various processes and methods described herein can be preformed wholly on a single client or server computer or the operations can be distributed among several client and/or server computers.

Methodology and System for Generating an FIOSM According to Embodiments of the Present Invention

Methodologies according to embodiments of the present invention for the design of a new, or modification of an existing, computer languages compliant with the generation of FIOSMs are described. Further, embodiments are described for processes and operations of generating of FIOSMs for any program written in a FIOSM-compliant language.

A concrete example of a FIOSM-compliant language (named ioExample) is provided herein below which demonstrates how the embodiments described generally in this section can be applied to a specific computer language.

There are two primary operations utilized in embodiments of the present invention, although as will be apparent to one of ordinary skill in the art given the benefit of this disclosure numerous variations and alternatives are obvious in light of this disclosure and the embodiments described herein. The first operation relates to the creation of a FIOSM compatible language, such that a FIOSM can be generated from any program using the compatible language. The second operation relates to the generation of a FIOSM for any program in the compatible computer language.

The following describes these operations in detail. The descriptions of the operations, while complete and enabling to one of ordinary skill in the art to which the invention pertains, are necessarily described generally since the operations and accordingly embodiments are applicable to many computer languages, or systems written in those programming languages. As mentioned above, an example of the application of the aforementioned operations as applied to a specific computer language is also provided.

The emphasis herein is on what is central to the implementation of the various embodiments and not on the specific operations utilized in portions of the implementation that are otherwise of common practice in the art. For instance, concerning computer language design, there are a myriad of texts on language design. Some exemplary texts include “Compilers, Principles, Techniques and Tools” by Aho, Sethi and Ullman, and “Introduction to the Theory of Computation” by Michael Sipser, all of which are fully incorporated herein by reference. Computer language design is also typically taught at an undergraduate level in computer science programs. Those of ordinary skill in the art to which embodiments of the present invention pertain have a basic knowledge and/or competence concerning language design. Consequently, there is not a detailed discussion of the theories and methodology of computer language design here.

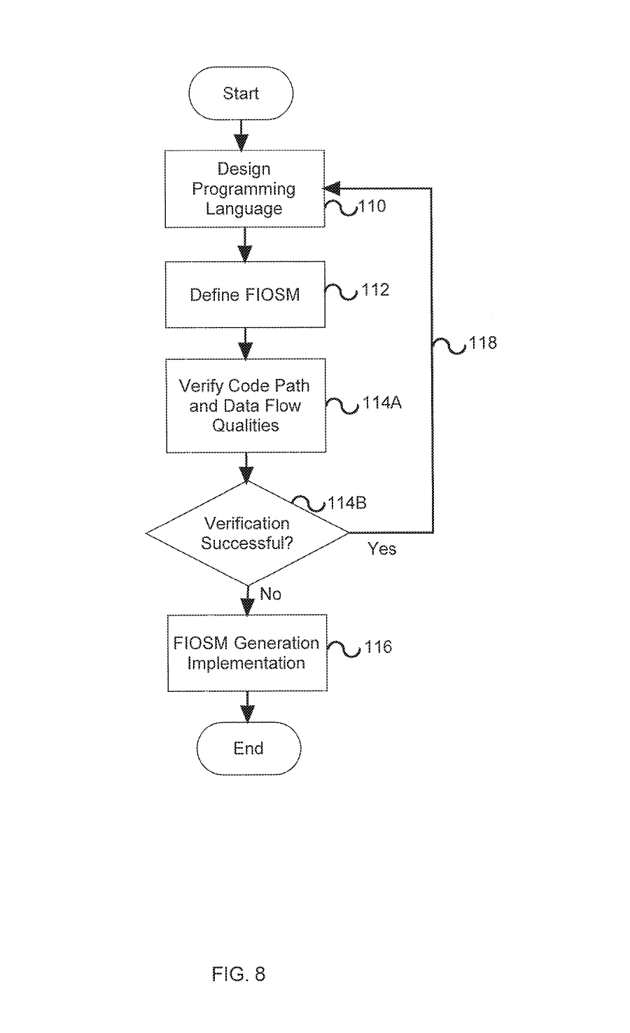

The Design and Verification process according to one embodiment as illustrated in FIG. 8 is comprised of four tasks: (i) Programming Language design 110; (ii) Finite Input Output Semantic Model definition 112; (iii) Finite Code Path and Data Flow verification 114A&B; and (iv) Automated FIOSM generation implementation 116.

The programming language definition task as indicated in block 110 is the definition (or design) of the language in question. The general design of a computer language is a task that commonly known by those of ordinary skill in the art and is not described herein at length. However, for any computer language to be capable of generating a FIOSM for any program written in the language it must also be compliant with Finite Code Path and Data Flow qualities.

The definition of the FIOSM as indicated in block 112 details the format and content of the FIOSM. This is discussed in detail below.

The verification of the “Code Path” and “Data Flow” qualities for a language is indicated in blocks 114A&B. As mentioned, a programming language or system of programs must satisfy these qualities in order to be able to generate a FIOSM for any program written in the programming language. This is described in detail below.

Finally, for particular program or system written in the FIOSM-compliant computer language, a FIOSM is generated, typically using automation as indicated in block 116. As previously indicated, the FIOSM is the foundation of the benefits of automated analysis offered by embodiments of the present invention.

One should note that the flow chart of FIG. 8 contains a loop back 118 to language definition of block 110 if the verification step is not successful. Verification of “Finite Code Path” and “Data Flow” cannot be guaranteed for every language. In fact, as mentioned in the Overview, mainstream programming languages in use are not compliant and cannot generate FIOSMs. Often, compliance can be obtained by modifying a language by removing certain features and/or operators. As is indicated herein, many of the features that need to be removed are not necessary for a significant portion of programming related to software for science and industry.

In other instances, operators or features may be redesigned to impart necessary functionality but also be FIOSM-compatible. This loop indicates a potentially iterative process where the language designer may be compelled to refine a programming language relative to its features and operators in order define a language that is verifiably FIOSM-compatible.

Programming Language Design

In reference to block 110 of FIG. 8, this section describes the design of FIOSM-compliant languages according to embodiments of the present invention. In a sense this section anticipates the verification section below, since the sensitive features of a language are precisely those that must be examined during verification.

An exemplary goal of the language design process according to embodiments of the present invention is to maximize the expressiveness of a language for the types of problems that it is used to solve, while retaining the ability to generate FIOSMs.

Programming language definition is not fundamentally influenced by grammatical syntax, or visual appearance. Rather, operational semantics is the most important aspect relative to designing a FIOSM-compatible language. As it specifically relates to programming language design, Semantics is concerned with the meaning of the program operators (or equivalently: the program statements).

Grammatical syntax is a common expression in the art of designing programming languages. It refers to the visual form of the text or graphic display that constitutes an expression in a computer language. Languages vary enormously in regard to their syntax. They can vary not only the text expressions they use for constructs, but also more fundamentally. For instance, there are some languages whose syntax is defined by the visual graphic display used for building programs.

In contrast, the Semantics of programming operators refers to the actual action that these operators embody during the execution of a program in which they are utilized, that is, their meaning or behavior. The vast majority of programming languages have almost identical program operator semantics, even though their grammatical syntax is quite different from each other.

In the FIOSM programming language design operation as performed according to embodiments of the present invention, one is concerned with the semantics of the program operators, not with their syntax.

Control-flow operators are extremely important considerations for language design. Control-flow operators are direct the program's algorithm to different sections and calculations. They include such program operators as “procedure-calls,” “if-then-else,” “for,” “while-do,” “goto” and others. Both general recursion and general looping can easily provoke infinite loops. A procedure that does nothing but call itself will loop infinitely until an associated stack is exceeded. A “while-do” loop without a termination condition will loop infinitely. Such program operators must be converted to ones that cannot provoke such behavior.

Simply put, for a FIOSM to be finite, one must eliminate control-flow operators whose semantics result in ambiguous or infinite code paths.

To retain the expressiveness or algorithmic power of the programming language while making the language FIOSM-compatible, the language's set of program operators are adjusted by replacing certain program operators that permit generalized looping with new operators that prohibit generalized looping but allow for decidable looping. Despite prohibiting generalized looping, the new operators, have semantics that achieve the target function of the replaced operators.

A simple example can illustrate the point. Often “for” loops are used to sum or determine maximum values of lists of numbers. This generalized loop can be replaced with a “sum” (or “max”) operator that processes a list of numbers with the same result, but the semantics clearly avoid looping. There is no possible way that a programmer can code a “sum” operator and provoke an infinite loop.

As with control-flow program operators, consideration of data types and their operators is foundational to the design of FIOSM compliant languages. A FIOSM is comprised of data expressions, both literally and conceptually. In order for a program's FIOSM to be created, the state of every data element in the program must be able to determined. This requires Data Flow to be calculated for every possible program operator that affects data state, for every data type. This is discussed extensively below in the section concerning verification.

It suffices at this point to state that data types and the program operators that change their data elements are a principal and crucial consideration in language design.

FIOSM: Syntax and Semantics Definitions

In reference to block 112 of FIG. 8, this section describes the format of a FIOSM according to and as utilized in embodiments of the present invention. The FIOSM defined and described herein determines the form generated by the generation algorithm discussed in its section below.

There is an intuitive simplicity to a FIOSM that helps both with comprehension and with organizing the task of defining the format of the model. The word “semantics” in logic is equivalent to the everyday concept of “meaning.” The semantics of a computer program is its meaning, its behavior, what it does.

A question programmers routinely ask concerning a programming project is: does this program do what I want it to do? The “doing” is entirely its effect on data, for instance, on a business's database. Users and owners of computer systems are concerned only as to whether or not a system has the expected and desired effect on data.

For example, when a call center looks up a customer's information in a database, the employee enters a name, and gets a customer's record back. The employee cares only that entering the name (input), brings back the right customer record (output).

A similar example is one where the customer wants to change his or her address. The call center employee enters the customer's name (input) to get the record, updates the address field, and has the customer's record updated in the corporate database (output).

The internals of how the procedural code accomplishes these changes are irrelevant to the call center employee, and to the owners of the business. There are endless different ways for programmers to write programs for look-ups and updates. The enterprise does not care which approach is used, as long as it does what is expected. The “expectation” is conceived in terms of input and output: “I put these data in for input, and I get these data back for output.”

The task at hand is to design/configure/develop the format of all possible FIOSMs associated with a specific FIOSM compatible programming language. The task is comprised of three sub-tasks: (i) defining all possible Data Constraint Expressions, i.e., a conditional data expression that tests the value or set of values a data element may assume; (ii) defining an Input-Output Pattern of Data Expressions, and; (iii) defining the Finite Input-Output Semantic Model (composed of all the possible input-output patterns).

Data expressions are the elements of the Input-Output Pattern of Data Expressions. They are, in essence, constraints on the values of data elements. Each individual constraint expression makes a unambiguous statement that restricts the value of a corresponding data element. This notion of data elements and data constraints is described herein.

The creation of an FIOSM is somewhat simplified by the fact that a data expression need not be defined for each data element, but rather for each data type. As is commonly done in computer languages, any data element (or variable) has an associated data type declaration.

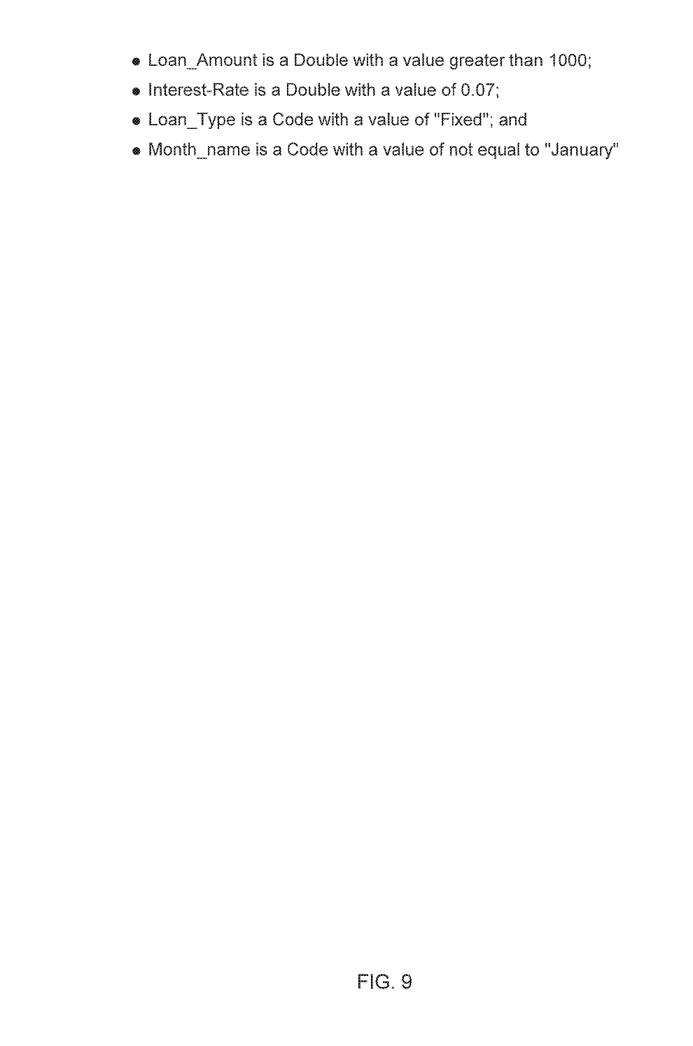

The typical constitution of data constraint expression is: (i) data element name; (ii) data type; and (iii) data value constraint expression. These data concepts have their commonly understood meaning in computer language design and programming. Some intuitive examples are illustrated in FIG. 9.

By defining the format of data expression for a particular data type, the data type definition can be validly applied to all data elements using the data type. Once data constraint expressions are defined for all data types utilized in a particular programming language then all data elements in a program written in the language will be considered.

Accordingly, each data type to be used in the language must have a corresponding data constraint expression for the FIOSM that satisfies the following qualities: (i) it must be lexically finite, i.e. it can be expressed in some text form finitely; (ii) it must represent a defined set of values, i.e. it is not ambiguous; and (iii) there must be a known method to definitively determine a subset relationship between any two data constraint expressions. “Lexically finite” means that the text used to represent the expression cannot be infinite; if it were infinite then the FIOSM would be infinite and therefore not a FIOSM.

That the value is a set of unambiguous values means that one must be able to validate, given a constraint expression and a data type value. The question to be answered is: does the value satisfy the expression? In essence, every value of the data type must either be a member of the described set, or not a member of the described set. It cannot be ambiguous.

In regard to a FIOSM and defining a data expression, data types fall into two categories: enumerable, and not-enumerable. Establishing a data expression for each of these types is discussed below.

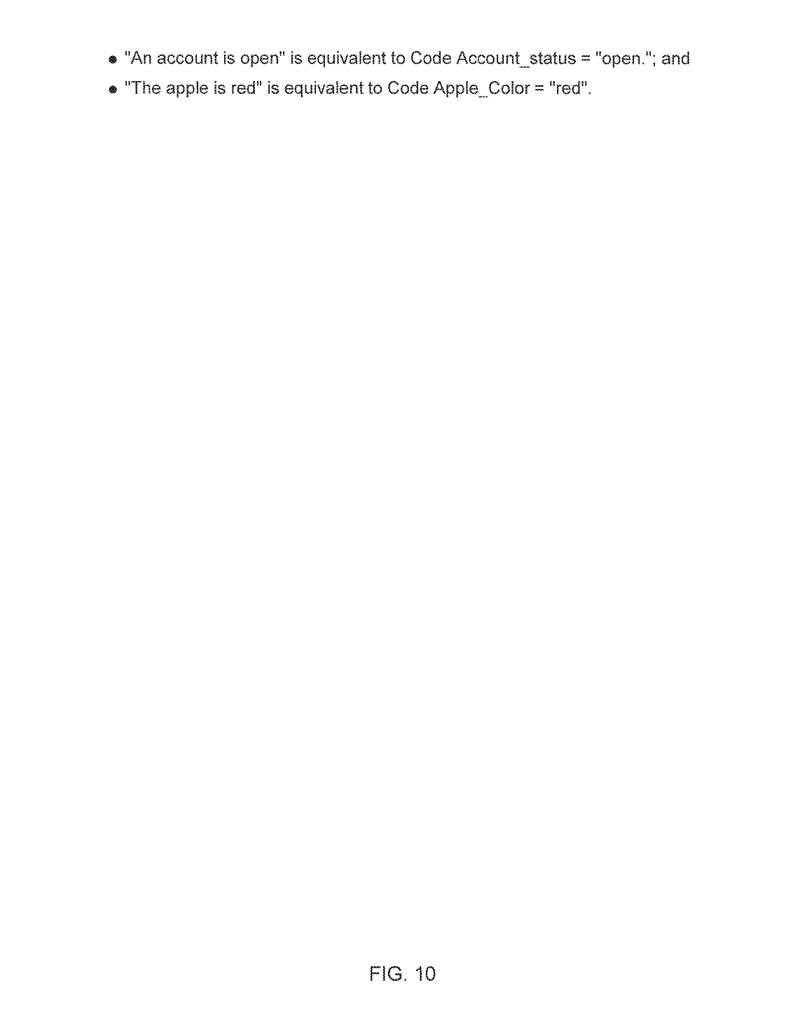

“Enumerable data types” are those that have a finite number of possible values in any single computer program or system of computer programs. An example of enumerable data type is Code. The Code data type represents a state or attribute of an object, analogous to an adjective modifying a noun. Intuitive examples of Code are illustrated in FIG. 10.

Codes, by the fact that the values are declared in a program, used, and never altered, are a finite set in any program. If the program is finite, then the set of declared unchanging codes must be finite as well. They are, therefore, countable or enumerable.

In summary, for enumerable data types, there are only finite countable sets of values.

Enumerable data types constraint expressions may be represented simply by comparison to finite values.

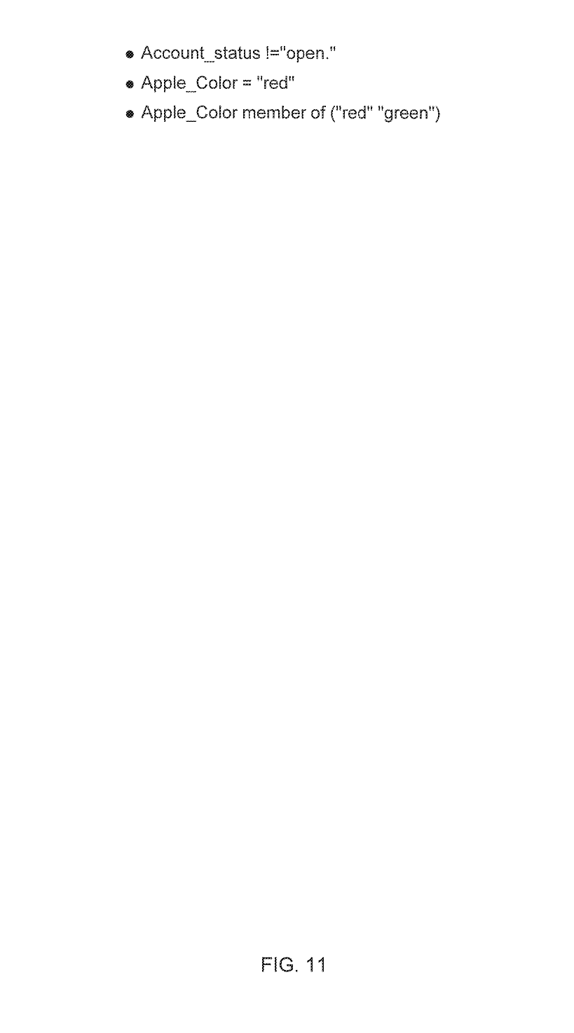

Enumberable data types constraint expressions can take the form: <DataElementName><EnumComparisonOperator> <ValueEnumeration>. <DataElementName> is the name of the data element, and <EnumComparisonOperator> is a data comparison operator that operates on specific values. <ValueEnumeration> is either a value itself or is a list of values. Examples of Enumerable data constraint expressions in the indicated form are illustrated in FIG. 11. This approach to defining constraints can obviously satisfy the requirements listed above.

Some data types have infinite values, and in any system the possible values of corresponding data elements cannot be enumerated finitely. For this category of data type, a different representation is necessary that allows a complete semantic description of a set. Numeric data types are the most typical inhabitants of this category. For example, in any real line segment, no matter how small, there are an infinite number of values (see caveat below) within the line segment.

By way of example, a data element like Interest_Rate could be constrained to having a value set between 0.07 and 0.072. Thus valid values could be 0.071, 0.0711, or 0.07111, and so on infinitely. In other words, they cannot be finitely enumerated. Obviously this contradicts one of the requirements of a data expression for a FIOSM, that they be expressed in a finitely lexical fashion.

One challenge concerning embodiments of the present invention is to express an infinite set with a finite lexical notation. In some embodiments, pre-existing constraint expression formats are used or adapted often in a straightforward fashion, as is illustrated in the example below. By reusing an existing form of constraint expression avoids having to create one. In other variations or embodiments, new constraint expression formats can be created as is necessary or desired.

As mentioned above, numeric data types are typically fall into the not-enumerable category. Fortunately, universally accepted numeric expressions for equalities and inequalities completely conform to the requirement of the not-enumerable data types. This approach combines the data element name, with a typical numeric operator, and a numeric value. Examples of real number constraint expressions include: (i) a geometric ray on the number line can be expressed as an inequality, such as Interest_Rate >0.70; (ii) an open or closed line segment can be expressed as a conjunction (AND) of two inequalities, such as Interest_rate >0.70 AND Interest<=0.80; and (iii) the combinations of line segments, points, open-points can be used to describe completely any expressions using disjunctions (OR), such as Interest_rate >0.70 OR Interest_rate <0.50. The actual set of possible constraint expressions is dependent on the operations that are allowed in the programming language. This is discussed below.

Before discussing the effect of operators on the not-enumerable data types, a brief caveat on numeric data types is in order. Those familiar with the computer implementation of fixed-point and floating-point numerics may protest that in implementation there are actually a finite number of values in any “real” line segment.

Even so, to represent numerics as an enumerated data type is possible but has several potential drawbacks: (i) practically speaking, numerics are infinite, and managing them as a set of discrete values transforms the model into an intractable size, and the use of numeric expressions is much more concise; and (ii) The mechanics of mathematics (function theory, algebra, etc.) are built upon the use of numeric expressions (such as those described above), and adopting an enumerated approach jettisons those mechanics, which can have a deleterious effect on identifying algorithms to use in verification and generation. Nevertheless, embodiments and variations can be contemplated wherein numerics are represented in an enumerated fashion.

In the case of non-enumerable data types, the format of the FIOSM's data expressions will fundamentally depend on the program operators and operators used in the source language. The data expressions for the FIOSM must have either equivalent or greater expressiveness than the program operators that affect the values of a data type. An example is numeric comparison expressions. If the program language allows one to code “Interest_Rate=<0.70” and the FIOSM data expressions have the comparison operator “<” but not “=<” then the FIOSM data expressions are incomplete and incorrect. (Note this example presumes the exclusion of “OR” in numeric data expressions). Another more subtle example would be numeric, in which certain transcendental functions would require an infinite series of line segments to express their behavior without recrafting the FIOSM format.

Obviously, “expressiveness” does not mean what the syntactic format is. If in the above example the FIOSM data expression could be expressed as “Interest_Rate <0.70 OR Interest_Rate=0.70” then there is no problem. Expressiveness here refers to semantics.

The FIOSM requires data elements to be named and identified, but does not necessarily require higher order information abstraction. For instance, Entities are an abstraction associated with information management, and are important in that context, but Entities are not required from a FIOSM perspective. In the context of modeling the FIOSM, all that is required is that the data elements be identified. Whether they are organized by “Entity” is merely a matter of naming convention.

In a final note on categorization of data types, some common data types may be enumerable in one programming language, and non-enumerable in another. The “String” data type can be used as an example. Consider a language where Strings have capabilities similar to the Code data type above. In this context, Strings are declared but there are no program operators that can change or create them. They are merely declared and referenced. In this language, “String” is enumerable. Consider alternatively, many common source languages, C for example. In C there are a rich set of program operators that allow for the creation and manipulation of Strings. Since the actual set of Strings created and composed is dependent on “inputs,” they can be practically infinite. Hence, in this example, String is a non-enumerable data type.

The foregoing paragraph again emphasizes the close relationship between designing a programming language operator, and creating a FIOSM format to support the semantics modeling of it.

A single pattern is referred to as an Input-Output Pattern of Data (IOPD) Expression. This merely means that it is a single instance of an input-output pattern for a particular program. As an example, assume that someone writes a program in the programming language that accepts loan parameters for input (Loan_type and Todays_Cap) and calculates in some fashion a specific associated interest.

The form of a corresponding IOPD pattern would be: Input(Loan_Type=“Auto”, Todays_Cap <0.9) Output(Interest_Rate <0.70 AND Interest_Rate=Todays_Cap=0.20).

For a modeled program corresponding to FIOSM, if one feeds values from the input portion of the pattern that “match,” then the output expressions will determine the output values. Using this example, one would expect if the input is (Loan_Type=“Auto” and Todays_Cap=0.80) then the output would be Interest_Rate=0.60.

For the same program, this pattern says nothing about the behavior if it does not match the pattern. For instance, if the input is (Loan_Type=“Auto” and Todays_Cap=1.0) then, since the input pattern does not match, this IOPD's output pattern is not applicable and the whole pattern instance is discarded.

More formally, an Input-Output Pattern of Data (IOPD) Expression is composed of two sets. One set is an input set of Data Constraint Expressions. The other set is an output set of Data Constraint Expressions. An input data element may appear in the calculation of output data elements. The input set of data expressions represents the inputs to the modeled program. The output set represents the output data expressions from the modeled program.

One logical form of the IOPD Expression can comprise:
(Input(InputDataExpression1 . . . InputDataExpressionN)
Output(OutputDataExpression1 . . . OutputDataExpressionN))

The sets in each case can be arbitrarily large, but will be finite if the programming language is FIOSM-compatible.

In the interest rate cap example above, the output values are expressed in terms of the input data elements. This is often the case, since typically output is determined by input.

Appropriate Data Constraint Expressions connecting output data elements to input data elements are produced in the FIOSM generation process as discussed below concerning block 116 of FIG. 8. Further, the process is illustrated concerning a particular and specific example in a later section.

The IOPD pattern defines a statement about the behavior of the associated program, about its inputs and outputs. The statement informally says that if the input is consistent with the input set, then it will be consistent with the output set. The IOPD is, in essence, a “production rule,” and its semantics are similar.

Concerning the Input Set, there is an implicit logical conjunction (“AND”) between the members. For every data element in the input pattern, it is determined whether the input data element value is logically consistent with the corresponding data expressions. If they are consistent, then there is a match. This operation is similar to the pattern matching of rules-based-systems (e.g. CLIPS) or Prolog or other logic programming systems.

Concerning the Output Set, for every reference to an input data element that appears in a data expression, it is replaced with the corresponding value from the input data element. Next, the data expressions in the output set are simplified. This again corresponds to the same “binding” approach taken commonly in logic programming systems such as Prolog. In Prolog, the “tail” of a clause is bound in a similar fashion.

For any particular source program, the corresponding Finite Input-Output Semantic Model (FIOSM) is the accumulation of all possible patterns of input and output. This corresponds to a mathematically complete set of IOPDs.

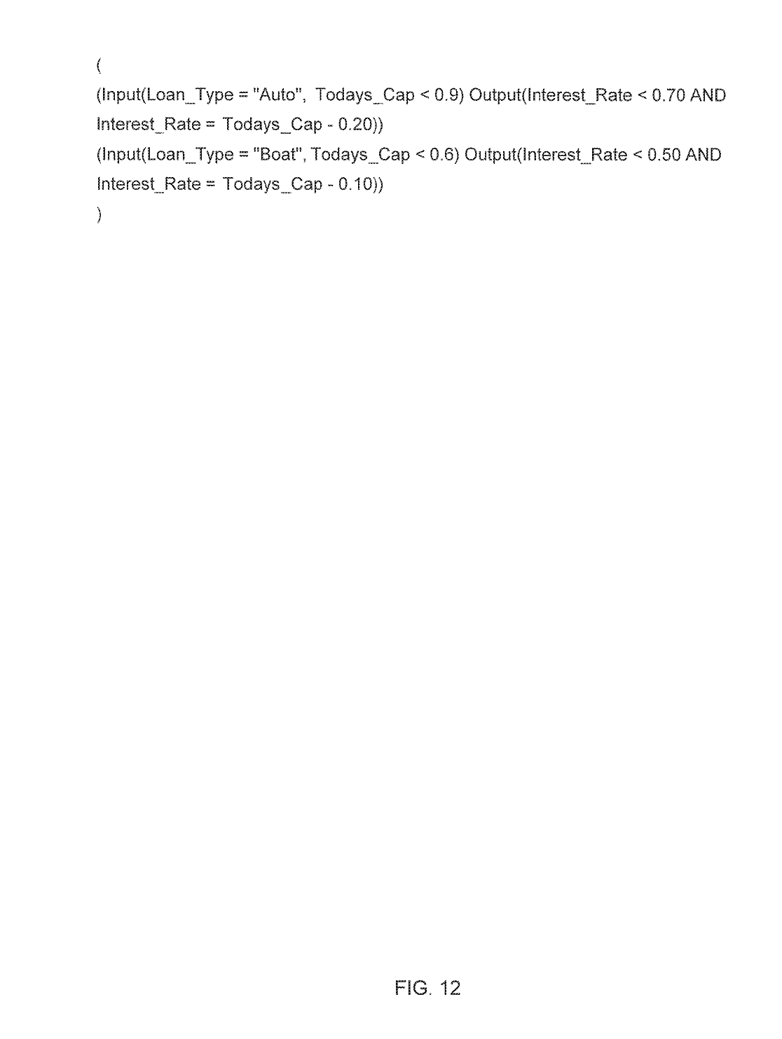

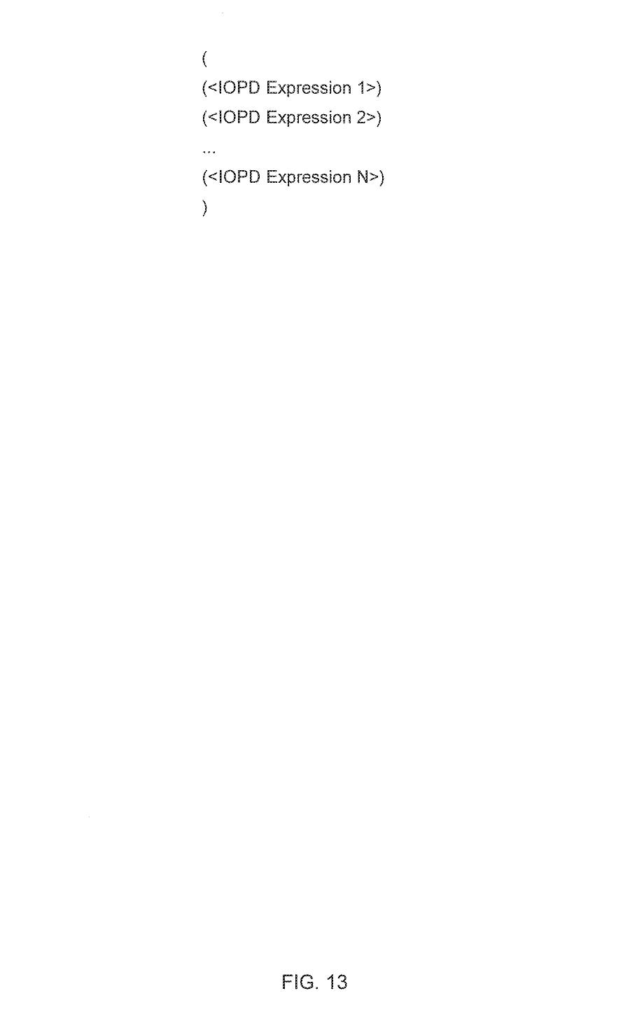

Using the example of the program given above, this Model does not describe merely one pattern, but rather all possible patterns. FIG. 12 provides a representation of the totality of behavior of the example interest rate program. More formally, the format for any program generated from an FIOSM-compatible language can be logically represented as a set of IOPD expressions as illustrated in FIG. 13. The usage of the word “set” is formal: there is no repetition of members in this set. Each IOPD expression is unique. Further, no two IOPDs can be combined to form a valid IOPD; this is equivalent to saying that no two IOPDs in the set mathematically partition another potential IOPD.

The semantics of the FIOSM corresponds to the behavior of the corresponding program. From a logic perspective, there is an implicit disjunction (“OR”) between every member of the FIOSM set.

To assess the program's input-output behavior, given particular values for input data elements: (i) every IOPD in the set is tested for a match; and (ii) for every input match, the output expressions are evaluated and returned. The overall FIOSM modeling approach guarantees that the results of the FIOSM will be identical to the original program. This proposition is referred to herein as “completeness and correctness” and it is discussed further below. The gist is that the FIOSM, given that it is consistent with all the requirements described herein, completely describes the input-output behavior of the corresponding program.

Programming Language Compliance

To be assured that any program in a programming language can generate a FIOSM, it is necessary to demonstrate that the language is compliant to the FIOSM requirements. As indicated in block 114A of FIG. 8, this is accomplished by verifying the code path and data flow qualities of the language relative to FIOSM definition created as discussed above and as illustrated in block 112.

There are two characteristics that must be satisfied in order to demonstrate this compliance for a programming language. The first characteristic is that any finite program must always produce a finite “code path.” This characteristic can be referred to as the Finite Code Path property. The second characteristic is that language must be complete in regard to data flow analysis, which can be referred to as the Data Flow property. These two characteristics are described and discussed in greater detail in this section. Furthermore, the application of the verification process for these characteristics is applied to a specific example in a later section.

In the following sections is a discussion of “proofs” of various characteristics of a computer language. The precise meaning of “proof” is most closely akin to the usage in mathematics: a proof is a demonstration of validity of a proposition. In this disclosure, “proof” takes on a slightly more practical character, that of assurance of key qualities in a particular computer language, not formality. The proof itself is merely a means to an end: that the designer is certain of the necessary qualities. It is not necessary to “prove” to any arbitrary level of formality, just to be certain. Having said this, many of the proofs are found in the literature of academia, and thereby inherit formality.

The Finite Code path restriction requires that any finite program will execute a finite sequence of program operators (statements) regardless of the input to the program. An alternative definition of the Finite Code path restriction is that every program that can be expressed in the language will produce a finite code path model. This requirement is necessary because infinite code paths may result in ambiguous data element values, or worse, may never result in a successful termination of the program.

A Code Path is the sequence of program operators (statements) that are executed in a single invocation of a program. The Code Path involves every operator (statement) between invocation and termination. There are typically many Code Paths indicated in a program or system. Often it is the case that the code path will depend on the input data elements to the program. The most obvious program operator that can affect the Code Path is a conditional statement (if-then-else) that forces a split in the Code Path depending on a comparison. This implies that there are multiple Code Paths through a single program or system.

The set of all Code Paths and their data element dependencies is referred to as the Code Path Model. A Finite Code Path Model is a set in which each Code Path member is finite, and the set itself is finite.

For a programming language to be compliant with generating FIOSM, it is a requirement that: (i) any program that can be written in the language have a Finite Code Path Model; and (ii) a single process (or algorithm) exists for generating the complete and correct Path Model for any program written in the language.

As discussed above, languages that contain generalized loop operators and recursion operators are non-compliant. These operators can result in defining infinite Code Paths, as with this example, using a “for” statement: For (;;) {LoanAmount=LoanAmount+1}. This statement generates an infinite Code Path, as well as an ambiguous value of LoanAmount. A language that includes such an operator is non-compliant.

As can be appreciated, the Finite Code Path property depends intrinsically upon the program operators in the candidate programming language. With appropriate design and modification of a language's operators, many known and commonly used languages can be made to embody the Finite Code Path property. This compliance can be shown and verified by demonstrating that any and all code paths written in the language within any particular program or system result in a finite “Tree Model” or “Directed Acyclic Graph (DAG). “Tree Model” and DAG implication on the Finite Path is discussed and disclosed in detail in the ioExample below.

A tableau algorithm, which has been shown to be correct and complete for generating Tree Models, can be used to generate the Tree Model for most if not all compliant languages; however, in other embodiments different processes can be used as would be obvious to one of ordinary skill in the art given the benefit of this disclosure.

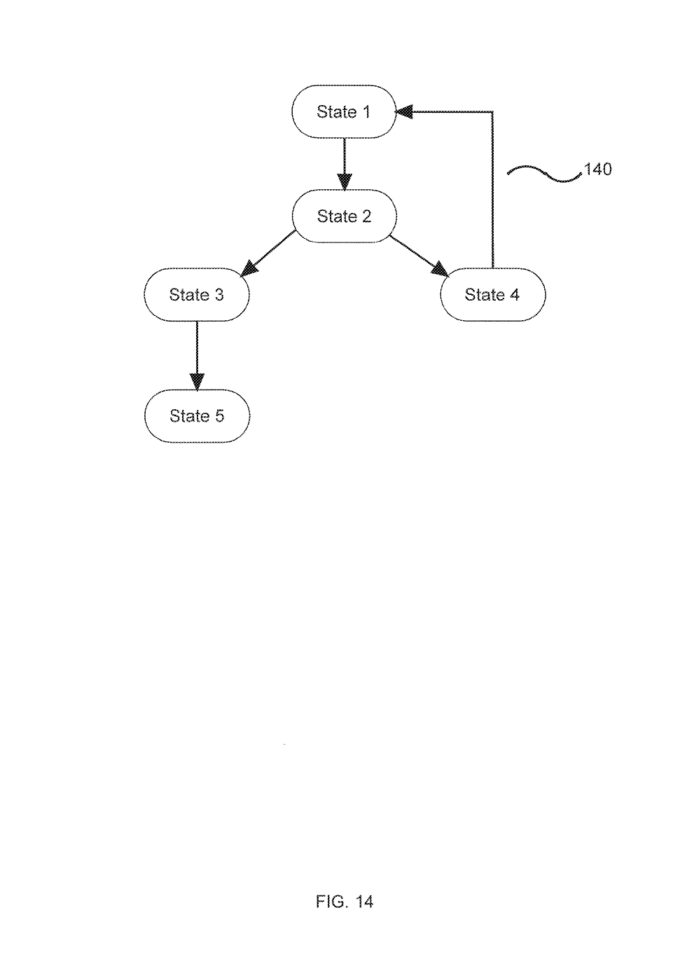

All procedural programs can be represented by the mathematical formalism “Directed Graphs” (DG). DGs are composed of nodes and arcs to form state-flow diagrams. An example of an arbitrary direct graph 140 is illustrated in FIG. 14.

In the context of programs, one can transform any program using the following formula: (i) each program operator is composed of an entry node and a series of operation nodes and one or mode exit nodes; (ii) the operation nodes represent the behavior of the program operator; these nodes form a path between entry nodes and exit nodes.

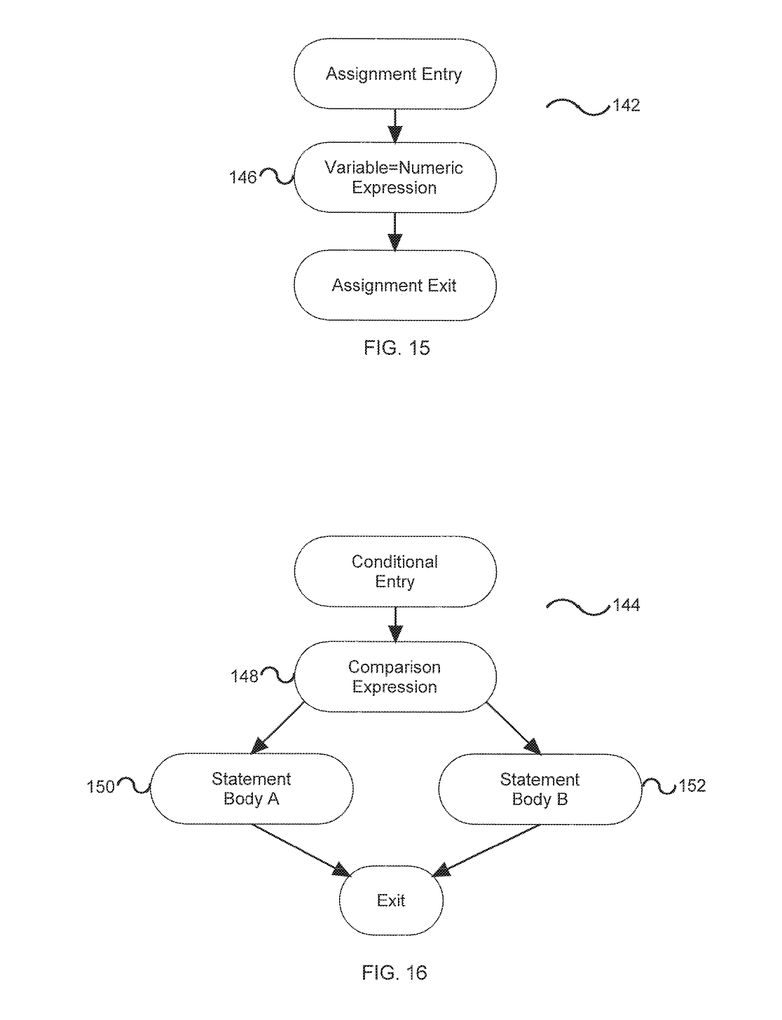

FIGS. 15 & 16 illustrates examples of two program operators from the ioExample language as described in greater detail in a later section: an assignment 142 and a conditional 144. In the assignment example there is only one operational node 146: the assignment itself. The conditional program operators are slightly more complex, containing three operational nodes 148-152 and a split in the directed graph, corresponding to the choice of which statement body to execute, depending on the result of the comparison.

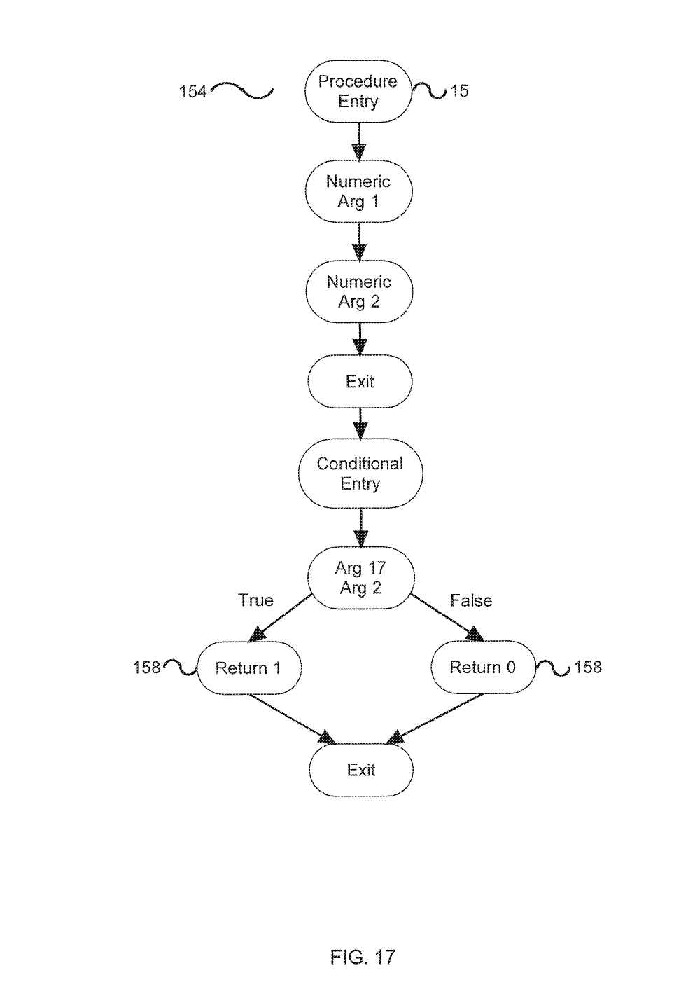

Given that all program operators are defined in this fashion, any program in a language can be composed by creating instances of program operator graphs and connecting exit nodes to entry nodes. This is precisely analogous to writing a program in text. FIG. 17 illustrates a simple program 154 as a directed graph. A program typically has a start node (root node) 156, and one or more end nodes (leaf-nodes) 158, these correspondingly represent the entry and exit points of the program. Note that in the example, the program has two implicit exit points, which are the returns in the conditional. The Nodes in between generally have a node-arc arrangement that is linear. The exception, as illustrated in the diagram, is the conditional that splits the “branch” into parallel branches that merge back together.

Directed Acyclic Graphs (DAGs) are directed graphs in which loops are disallowed. This corresponds to the “control changes” to previous program points. More precisely, loop in a directed graph occurs if an arc path is cyclical. That is to say, there exists a path such that, by moving forward in the direction of the arrows, eventually one can return back to the same node. Note that FIG. 17 is a directed acyclic graph. One of the obvious properties of DAGs is that in walking the graph in the direction of the arrows, one only passes any specific node but once. This is, in fact, the mathematical definition of a DAG.

One property of DAGs is that if one composes them, the result is also a DAG. In other words, given two or more DAGs, adding an arc between one or more exit nodes in one DAG to one or more entry nodes in the other DAG will always produce a DAG.

The proof of this property is relatively simple and straightforward. Given that there are two separate DAGs (DAGa and DAGb) that are composed such that for at least one exit node in DAGa there is an arc to at least one entry node in DAGb and the structures of the graphs are otherwise unchanged, then the composed graph is a DAG. Assume for sake of the proof that the composed result is NOT a DAG. This would imply that there was a loop in the graph. But both graphs are DAGs so there cannot be a loop “internal” to either. Otherwise, it would contradict the premise that they are both DAGs.

In addition, the added arcs between the graphs are unidirectional, so there cannot be a loop between the graphs. Accordingly, the existence of a loop is inconsistent with the assumptions.

Programs that produce finite DAGs have the finite code path property. This is the connection between DAGs and finite code paths. Computer programs and systems having a finite code path property produce directed graphs with a finite number of nodes. This is easy to understand since any program has a finite set of program operators in it, and each program operator produces a graph with a finite number of nodes. If a programming language can produce only finite DAGs, then it conforms to the Finite Code path property. If it were otherwise, then there would have to be at least one node visited an infinite number of times. This would be a contradiction to the definition of a DAG.

Languages in which all programs can be shown to be equivalent to finite DAGs are compliant with Finite Code Path requirement. Demonstrating that a language produces only programs equivalent to DAGs is straightforward and described below.

It is sufficient that a programming language has two qualities: (i) all program operators can be represented by finite DAGs, and (ii) the rules of composition are consistent with those described above concerning acyclic composition of DAGs. Since every single possible program in the language has a one-to-one correspondence to a finite DAG, the set of all possible programs in a language is covered. More formally in mathematics, this demonstration corresponds to a proof by induction.

The essence of Data Flow is to determine the value of any data element in a program, for any possible program written in the proposed programming language.

The core of the FIOSM is data expressions. Since any data element in a program can be output potentially, one must be able to algorithmically determine the value of any data element. This requires that every data element defined in a program can be resolved to a data expression (as defined above).

The Data Flow property is the selection and the embodiment of an algorithm or algorithms that implement this resolution of data elements to data expressions. The immediately following paragraphs discuss the qualities necessary for the algorithms.

To build a semantic model, one must be able to design a correct and complete process that determines the values of all data elements. Anyone of a number of suitable algorithms/processes can be utilized as would be obvious to one of ordinary skill in the art given the benefit of this disclosure. Furthermore, a combination of algorithms can be used as well.

Typically, one must consider the problem for each data type. By selecting an algorithm that is valid for all instances of a data type, one can reduce the activity to demonstrating the validity of an algorithm for each data type. As discussed above, the operators used to manipulate instances of a data type will fundamentally determine which Data Flow algorithm is appropriate. Thus for each data type, an algorithm that is complete, correct, and able to detect incorrectness must be used.

The algorithm must be complete since it must be used reliably for any possible program in the candidate language. “To be used by any possible program” means it must be complete. “Completeness” is concerned with ensuring that the algorithm will always give an answer.

“Correctness” requires that the algorithm will give only valid answers. This is obviously a requirement. It cannot be assumed that a correct algorithm will always give a valid answer for any input. “Correctness” may depend upon the correctness of input expressions. This is often whimsically called the “Garbage In Garbage Out” (GIGO) problem. Thus, for clarity, one must add a requirement to “correctness.” The data flow algorithm must be able to detect invalid patterns for data. Consequently, in addition to being a correct algorithm, the algorithm must be able to detect when the input itself is invalid.

As with the Code Path property, the Data Flow property is fundamentally dependent on the data types and the relevant operators. The pragmatic use of these logical qualities is discussed in more detail in below. Further, in a following example the use of an algorithm named Fourier Elimination to satisfy the Numeric and Code data types is illustrated using the ioExample language.

There are fundamentally two methods to algorithmically resolve Data Flow: analysis and approximation. “Analysis” uses some form of automated algebraic analysis to determine results. This approach is used in relative to the concrete example that follows in a later section.

“Approximation” uses specialized algorithms to approximate the result, and is typically encountered when dealing with numeric data types. Some programming languages will require numeric operations whose data flow is mathematically undecidable using algebraic techniques. An example of this is higher-order polynomial functions. In such cases, the only method to satisfy the Data Flow requirement is specialized approximation. Typically this is not a major issue, since the approximation algorithms can determine answers to an arbitrary degree of precision. The cost of using specialized approximation algorithms is typically more computationally expensive than algebraic techniques, and these algorithms are also less general in their application than their algebraic counterparts.

In the context of the Data Flow property, it is important to distinguish between the concept of “data element” and that of a variable as defined in a programming language definition. It is important to emphasize that the Data Flow requirement discussed here pertains to data elements and not to program variables.

A data element here is defined by its common definition in Data Modeling: it is a uniquely named data “concept” whose instances have a single value. An example might be Customer_Home_{—} Address. Each instance of this data element has a specific value. For the president of the USA it would be “1600 Pennsylvania Avenue.”

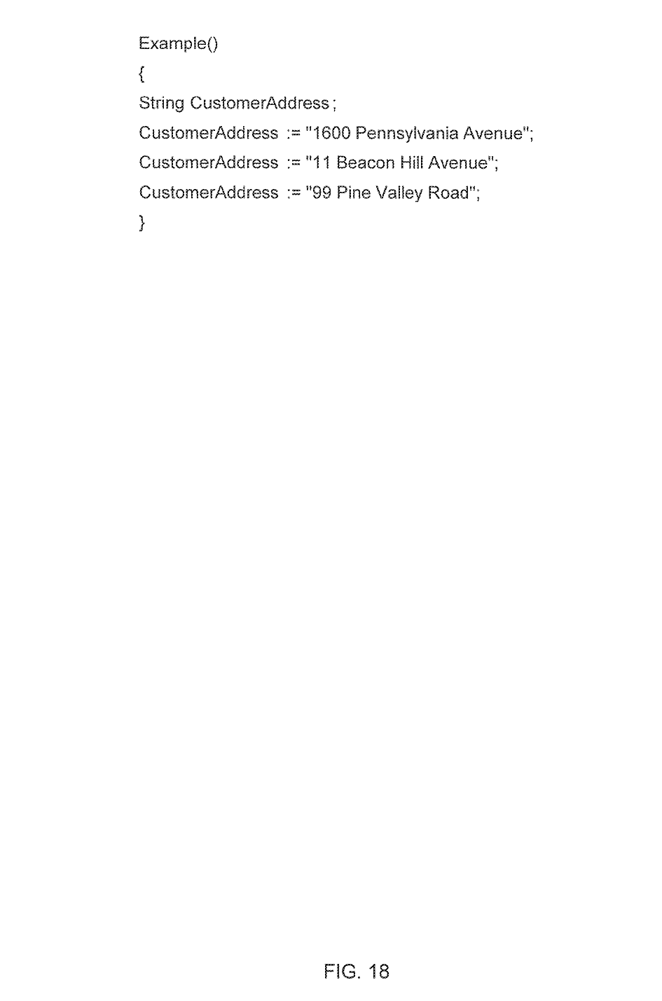

A source program variable is a named instance of a data type, whose instances can be procedurally assigned multiple possible values during the execution of a program. An example is provided in FIG. 18 for consideration. The “CustomerAddress” variable takes on three values during the execution. The variable itself does not represent an instance of a single data element.

From the perspective of Data Flow, the problem between “data element” and “variable” is that an instance of “data element” can have only one value. It is this aspect of “data elements” that makes them compatible with generation of the semantic model (FIOSM).

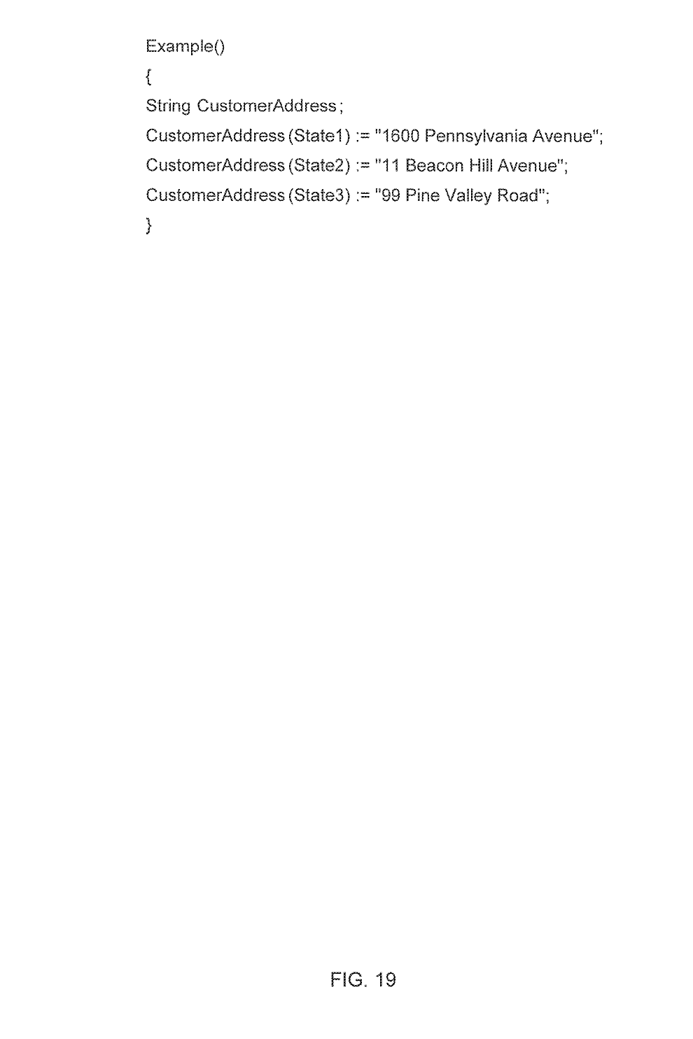

Since most programming languages use this variable construct, in order to meet the Data Flow requirement discussed above, one must convert “variables” into “data elements.” The essence of this technique is to recognize that each time a program variable is assigned a value, the variable in essence becomes an instance of a different data element. If one were to convert the above example of FIG. 18 by replacing each assignment for “CustomerAddress” with a unique “state variable,” then one would end up with a program as illustrated in FIG. 19.

In essence, the program's usage of the variable CustomerAddress is converted into a series of data elements. The Data Flow requirement can be applied to these. The algorithm calculating the data flow typically maintains the connection between the “state variables” and the original variable declaration. This issue of converting “program variables” into data elements is concretely illustrated hereinafter.

FIOSM Automated Generation Process

The previous section described a process of crafting and adjusting a programming language to be FIOSM compliant. The verification process also identified algorithms for generating the Code Path Model, and Data Flow Model. This section describes and discusses embodiments pertaining to the automated generation of a FIOSM. This generation process will work with any program written in a FIOSM compliant programming language.

The model generation process can be embodied in many different fashions, reflecting the different programming languages that are utilized, and the different algorithms that are employed to satisfy Finite Code Path and Data Flow.

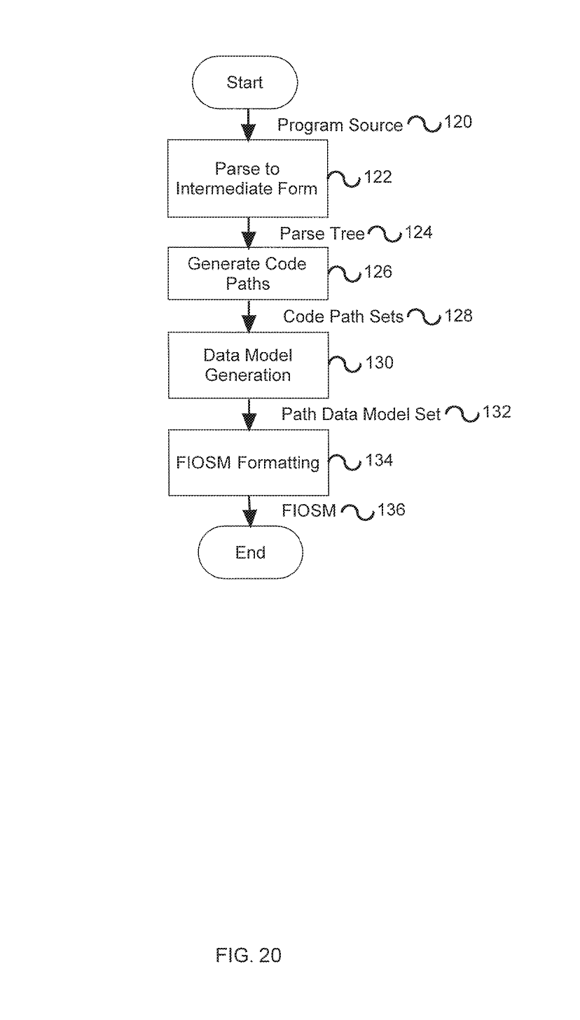

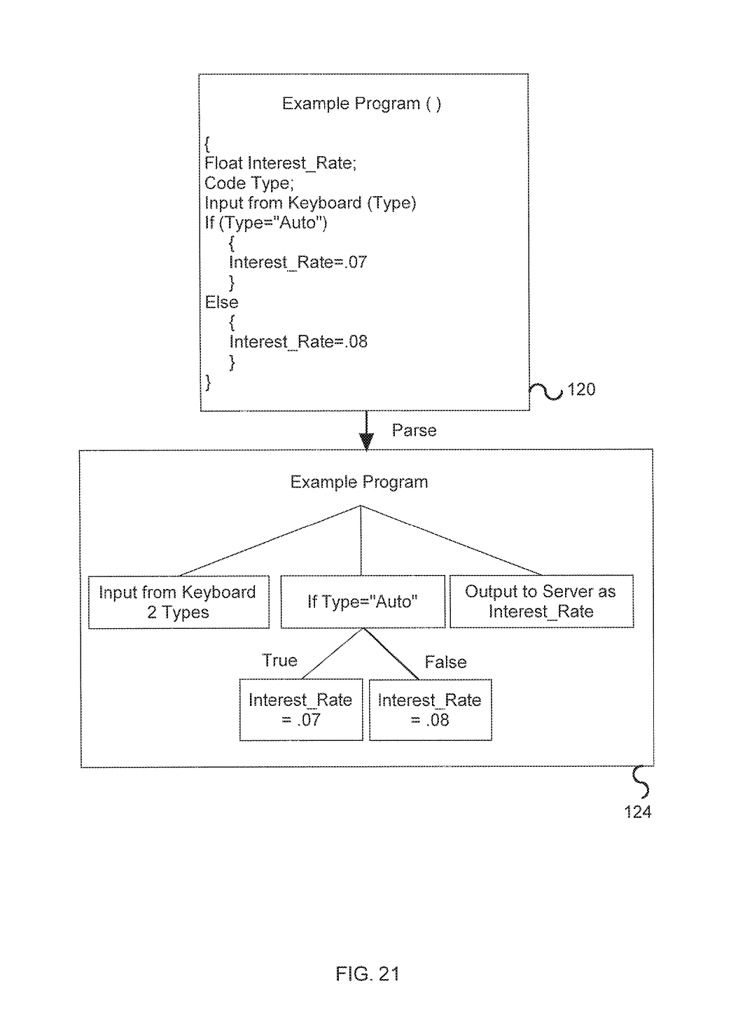

The general process of model generation includes four sequential operations (or processes). These four operations are illustrated together in the flow chart diagram of FIG. 20. Further, each operation is individually and concretely described in relation to FIGS. 21-25. A later section illustrates a specific implementation of this process, in which two of the four operations are combined for a concrete example.

The input into the first process 122 of the four processes is typically a source program 120 written in a FIOSM-compliant programming language. The source program is parsed into an intermediate form, an abstract data structure 124 (or Parse Tree). A parse tree represents the syntactic structure of a program in the form of a directed graph structure. The graph structure can be easily used to analyze the code path of a program.

FIG. 21 shows a simple program 120 that is then “parsed” to produce a parse tree representation 124. The diagram shows the input and output of the process. The illustrative program 120 merely accepts from the keyboard (input) the code for a type of loan, and returns to the screen (output) the associated interest rate. If the loan type is an auto loan, it returns 7%; for all others it returns 8%.

The bottom box of the figure shows the corresponding parse tree 124. The execution sequence of the program operators is to execute the left-most unexecuted branch completely before continuing to the right. This is a potentially recursive process. Where a statement block contains other statement blocks, the process needs to be able to process the imbedded statements. In execution, the conditional (if-then) has one of two possible sub-trees to execute, obviously depending on the outcome of the conditional test.

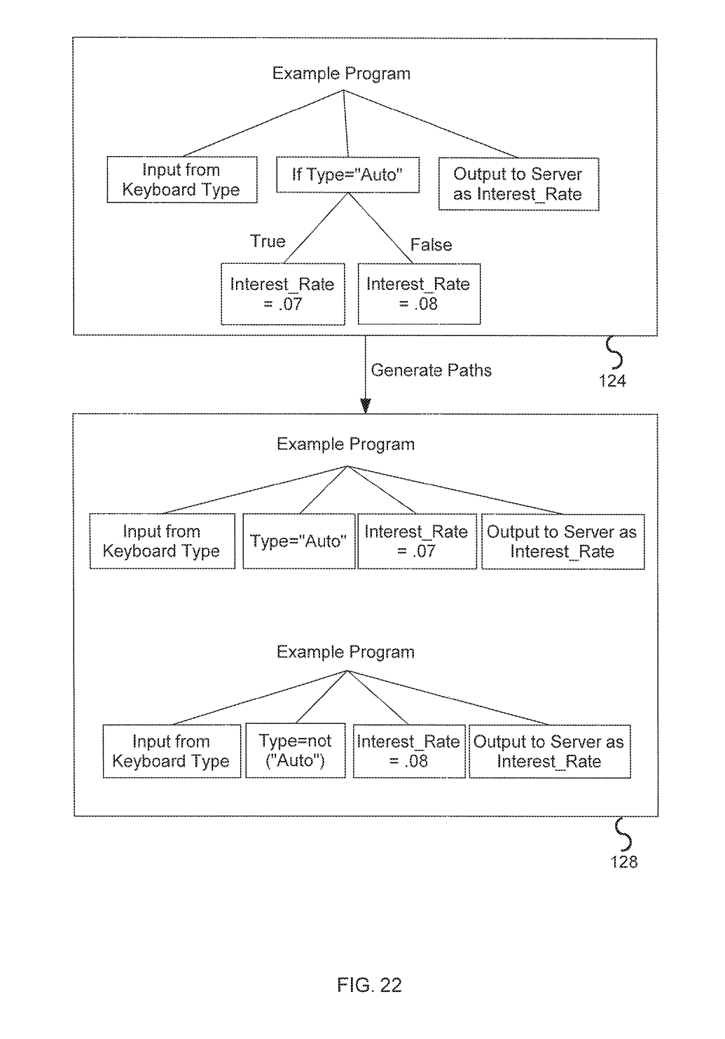

Next, the path generation process 126 takes an intermediate representation of a program (e.g. the parse tree 124) and produces a set of Code Paths 128 for the same program. The conversion of the illustrative parse tree 124 into code paths 128 is illustrated in FIG. 22. The process is clearly straightforward. The condition (if-then-else) forces a choice between two paths. The condition expression (the if-then statement) is replaced with a constraint (type=“auto” in one case, and type=not(“auto”) in the other. The dependent statement-block (assigning a value to interest_rate) is elevated to be a sibling node with the constraint. The value of the assignment corresponds to the constraint. For instance in the second case, where type=not(“auto”), this corresponds to the “false” branch of the condition, so the assignment selected for this code path corresponds.

Any suitable algorithm that is configured and used to walk parse trees and transform them to condition free code path trees as would be known to one or ordinary skill in the computer arts can be utilized to perform this process operation. Two common approaches are “model-splitting” used by the Tableau family of automated reasoning algorithms, and the book-marking algorithms commonly used by logic programming systems such as Prolog. A tableau approach is illustrated in relation to a concrete example provided in a later section of this disclosure.

The finite code path property required for model generation guarantees a Finite Code Path Model, and the existence of an algorithm. In the illustration, the FIOSM language uses only the if-then-else control flow operators and can be translated in the straightforward fashion illustrated.

The Data Model generation process 130 takes the set of Code Paths 128, and converts them into a set of logically consistent data element models or a Path Data Model set 132. Each consistent data element model represents one input-output pattern. It not only contains the state of those data elements that are visible in input and output, but also those “internal” to the program.

The phrase “logically consistent” is crucial. Often in programs, there are paths that cannot occur, even though a naïve analysis (i.e. without data flow consideration) says it might exist. In essence, a path can produce a requirement that a data element take on inconsistent values. An example of such a circumstance would be if a code path required that “interest_rate=0.07 And Interest_rate >1.0.” This numeric expression is obviously impossible to satisfy. Any Code Path that produces an inconsistent data model must be discarded.

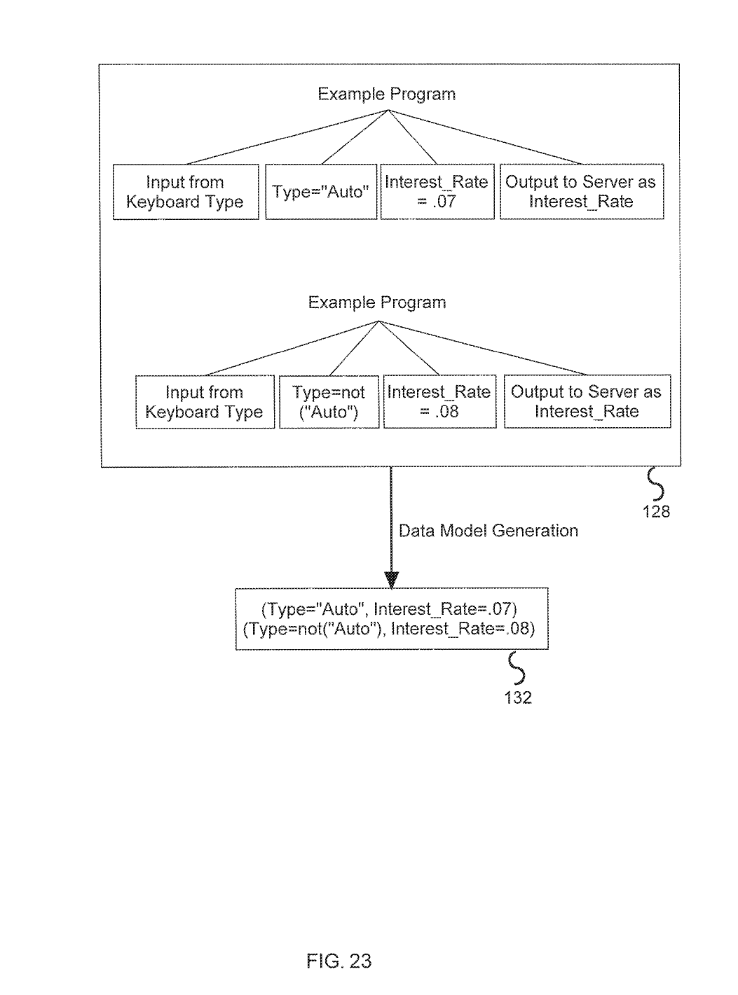

FIG. 23 shows the process 130 of generating a consistent data model. The input to this example is a set of code paths 128 from the code path generation section. The output is a set of elements 132 consisting of data elements and their value expressions. The Path Data Model set is produced simply by, for each code path set element, walking the code path parse tree and recording the assignments and constraints for each and every data element. Since both elements in the illustrative output set have logically consistent data models, neither is eliminated from the set.

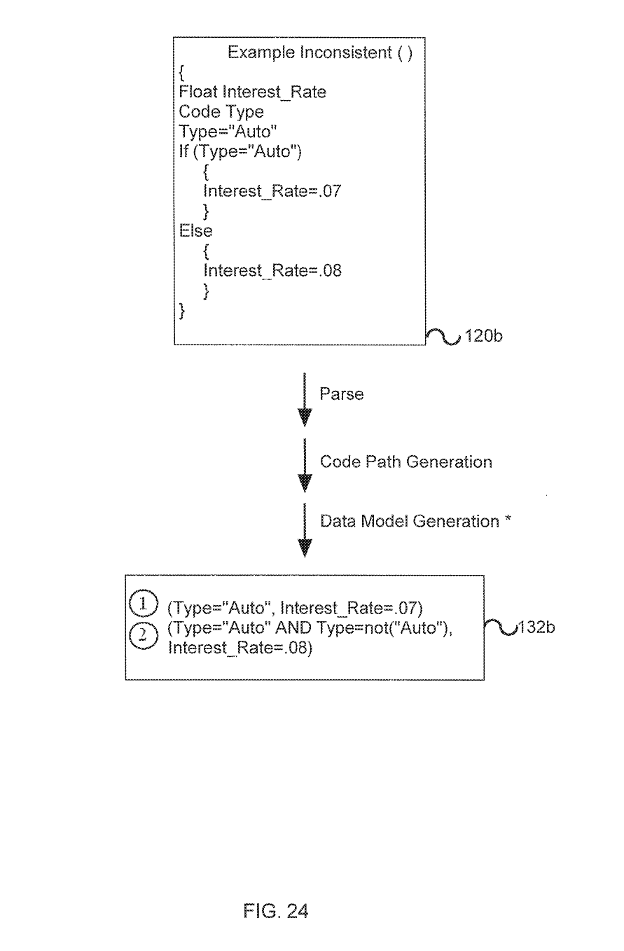

FIG. 24 shows an example of producing a logically inconsistent data model that should be removed. The diagram starts with a slightly altered example source program 120b. Instead of accepting a value of “type” from the keyboard input, this program assigns to “type” the concrete value of “auto.” The rest of the program is the same.

This program is then run through the parse process, the code path generation process, and the data model generation process. Note that data model generation has an asterisk since we are seeing the Path Data Model set 132b results prior to inconsistent model elimination. Intuitively, because the value of “type” is set to “auto” before the conditional (if-then-else), the “false” branch of the conditional is never taken. “Type” must always be “auto”.

This intuition is reflected in the second member of the data model set in the diagram. The portion of the data model for “type” states: “Type=“auto” AND type=not(auto).” This is a logical inconsistency for the data type Code: a single data element cannot have two values. Consequently, this element of the set must be eliminated.

The essence of embodiments of this process comprises: (i) walking the intermediate representation (code path parse tree); (ii) generating the data element value expressions; and (iii) testing each member of the set for data-element consistency.

Embodiments associated with an arbitrary FIOSM-compatible source language will be highly dependent on the data types that are used in the language. For each of these data types, one must be able to detect when it has consistent and inconsistent value expressions.

Often detecting an inconsistent data value expression occurs naturally in the Data Flow algorithm chosen for the data type. The Fourier Elimination algorithm used in the concrete example in a later section is an illustrative of this. It naturally detects inconsistency in linear numeric equalities and inequalities.

The final process 134 is the formatting of the finite input-output semantic model (FIOSM). The input to this process is the data model set 132 from the data model generation process 130. The output is a Finite Input Output Semantic Model (FIOSM) 136.

The gist of this process is quite straightforward: (i) identify the set of input data elements in the program; (ii) identify the set of output data elements in the program; (iii) for each member of the data model set, create an input-output pattern expression; (iv) for each input data element, use the data appropriate Data Flow algorithm to produce a valid data expression and add it to the input set; (v) for each output element, use the data appropriate Data Flow algorithm to produce a valid data expression and add it to the output set.

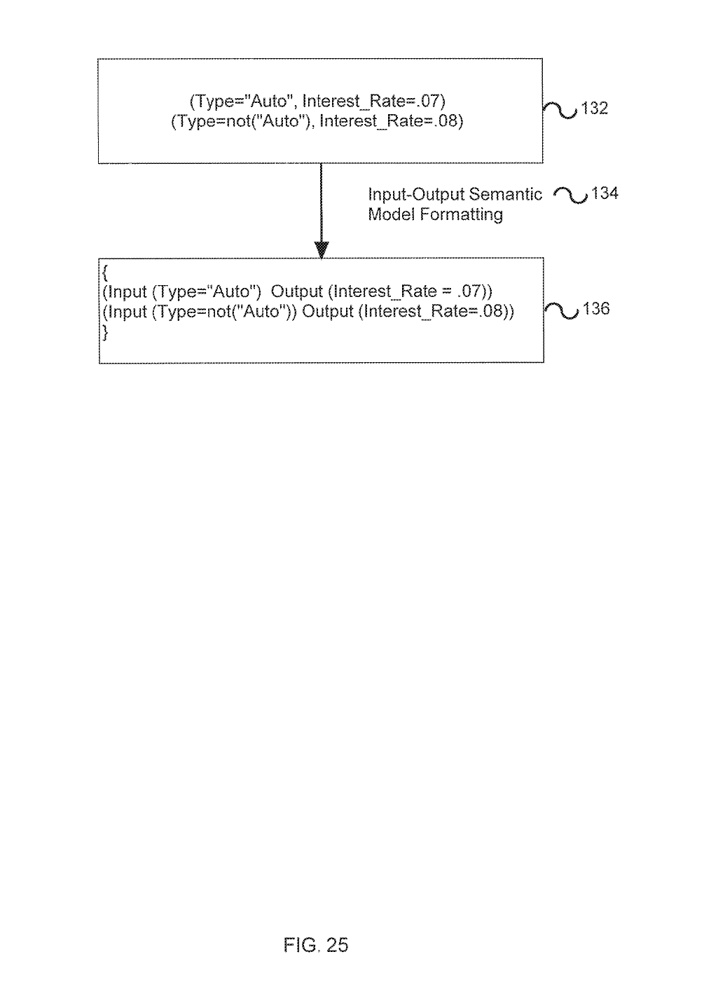

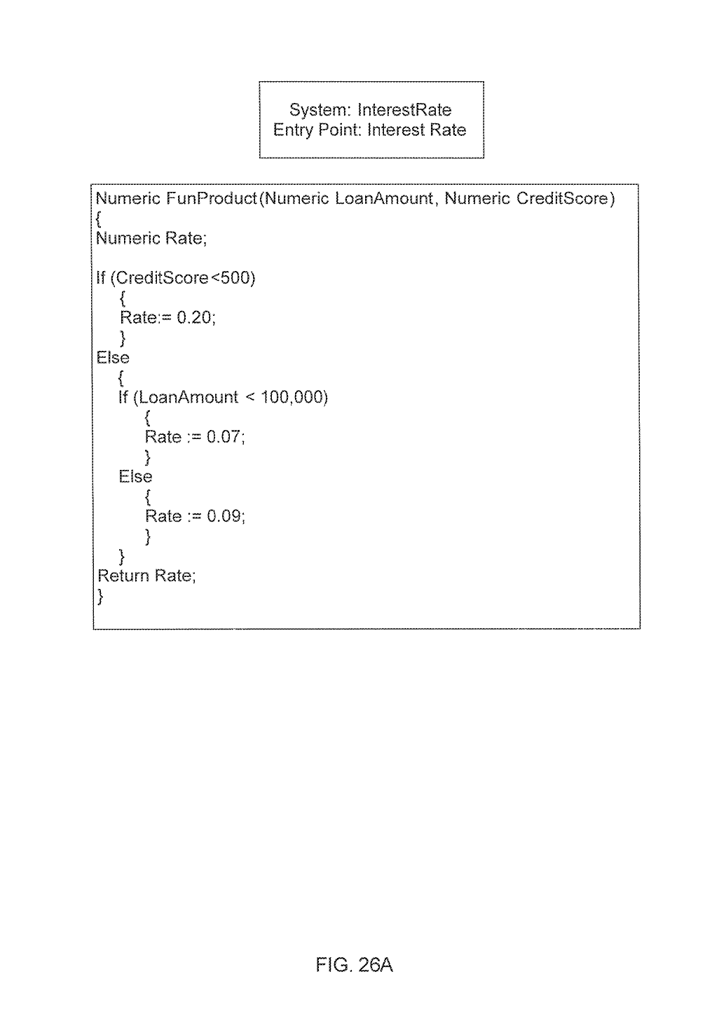

FIG. 25 illustrates the transformation of the Path Data model generation set 132 into a FIOSM 136. Identifying the input data elements is quite straightforward. Intuitively, the program operator “inputFromKeyboard” identifies which data element is in the input category: “type.” Equally straightforward in this example is identifying the output data element. The “outputToScreen” program operator identifies which data element is in the output category: “interest_rate.” Consequently, each member in the data model set is translated into a corresponding member in the FIOSM set. The input set of each IOPD pattern contains the corresponding “type” value. The output of each IOPD pattern contains the corresponding “interest_rate” value.

It is worth noting that, in this example, all the data elements in the data model participate in the FIOSM. This does not have to be the case. There can be “internal” and “intermediate” data elements that are used for calculations not a part of the input-output semantic model. These data elements or variables are simply not used. This aspect of model generation is shown in the much more extensive example provided in a later section.

The process of transforming the Path Data Model into the FIOSM is relatively straightforward. It rides upon the other processes. There are, however, two observations to be noted in regard to identification of input and output data elements: the use of the model, and the source language features.

The commercial use of the FIOSM may determine which data elements are considered input, and which are output. A couple of examples will suffice to illustrate this. Assume for this context that the source language is a block-structured language like “C,” that is FIOSM-compatible and that a business-oriented system is written in this language.

If the application of the FIOSM is a productivity tool for programmers, then the input might be defined as arguments to procedures and the output as return values. These choices are driven by the programmer's view of his work: writing procedures. He would want an input-output model of the procedures he has written.

If the FIOSM application is intended for businesspeople trying to understand a system's quality, the input and output might be defined by input screen values and output screen values (as in our simple example), respectively. In this context the choice is driven by the businessperson's perspective. He does not care about the internal source procedures; he cares only about the input and output that the business staff sees.

The larger point, for a single system, is this: there can be different choices as to what constitutes input and output. The choice is driven by usefulness in the proposed commercial application of the FIOSM. It is further understood that no matter what the choice of the inputs and the outputs, the resulting FIOSM will be finite.

The second observation to note is similar to previous comments about choices about source language structures. There are a myriad of possible FIOSM-compatible source languages, and the choice of program operators will affect the definition of input-output elements. If the language supports a database interface, the data manipulation language (DML) operators may be considered potential flags of input and output data elements. Similarly for languages or systems that have a Web Services interface, the same might be true.

There is one final comment on the elimination of intermediate or internal data elements. These are not required for the FIOSM, but with some applications they are useful to explain to the user of the model why a model pattern was generated. In some embodiments it is useful to be able to show how a model pattern was generated. This “how” shows the chain of assignments and calculations that produced the pattern. This constitutes a “debug trace” for a programmer-type whether in an IT department or a business department.

With reference to the elimination of intermediate or internal data elements, these are not required for the FIOSM, but with some applications they are useful to explain to the user of the model why a model pattern was generated. In some embodiments it may be useful to be able to show how a model pattern was generated. This “how” illustrates the chain of assignments and processes that produce the pattern. This in effect constitutes a “debug trace” for a programmer-type whether in an IT department or a business department.

Example

The following example at least concretely demonstrates:
The process of designing and verifying that a computer language can completely and correctly generate a Finite Input-Output Semantic Model
The implementation of a process, such as an algorithmic based process, to generate the FIOSM for all possible programs written in the language.

These two demonstrations are presented in the corresponding order, first defining the example language and the corresponding semantic model (FIOSM), and then demonstrating that the language is complete in regard to generating the FIOSM. This sequence parallels the description above.

The implementation demonstration follows. This section demonstrates in detail the exemplary processes and techniques used to convert any system written in the example language into a Finite Input-Output Semantic Model.

As illustrated above, these two major processes are connected by a computer source language, and the algorithms used in both processes. The connection between the two processes is that the first process provides language and some of the required algorithms to the second process.

As mentioned herein, computer languages can take many forms. The process described herein is used to design and verify that a language, regardless of its form, both is compatible with FIOSM generation, and that the necessary algorithms exist for successful error-free generation.

This example uses an illustrative example computer language, ioExample, to illustrate the two major processes discussed above. In structure, it is similar to the majority of those used in business software development, a so-called procedure-block structured language. This type of language form underlies the major languages in use, both “procedural” and “object-oriented.” Some of the languages that fall into this category are “C®,” “Java®,” and “C#®.”

The ioExample language is complex enough to serve as a compelling example embodiment for the mainstream family of computer languages, yet also is simple enough so as not to introduce repetitive and unnecessary complexity.

In addition to the language, there is some leeway in considering input and output; this is discussed at some length above. Since the purpose of this example is to serve as an example to implementers of this invention, and these implementers are likely to have an intensive software background, the definition of input-output utilized here is the most basic one appropriate for programmers: procedure input arguments and procedure return.

This simple definition of input-output is appropriate for creating analytical tools used by programmers to verify the correctness of their programs and systems.

Language and Semantic Model: ioExample Specifications and Proofs

The example language used in this embodiment is named ioExample. The first process is a planning process by nature, one that identifies the components necessary to implement the second automated process. In this first process, one must design a computer language, and a semantic model. Further, the process requires one to demonstrate that every program that can be written in the language has a corresponding FIOSM. The algorithms discovered in the first process (planning) are then used in the second (automated generation).

The following exemplary sections embody the process of:
Specifying a computer source language: ioExample
Specifying the “system” developed in the ioExample language
Specifying the Semantic Model (FIOSM) that corresponds to ioExample, and
Demonstrating that ioExample is “complete” in regard to the Finite Code Path, and Data Flow

Language Specification: ioExample

The example language (ioExample).
This section is not an exhaustive tutorial on the theory of computer languages, parsing, and compiler implementations. The theory is well known to those of average skill in the art. It is typically the subject of an undergraduate level course in computer science. Any person with an undergraduate degree in CS could implement this language from this description without difficulty. Further, it would unnecessarily complicate the description of this process to develop language and compiler theory from scratch.

The appearance of the ioExample will be familiar to any professional programmer. It has a procedure called syntax that is common in modern languages such as Cθ, Java®, C#®, etc. Further, the syntax of its expressions and statements are quite consistent with these mainstream languages. Consequently, the language should be intuitively familiar, and the implementer of this process should be able to adapt directly from these processes.

The description of the language is broken into two major sections. The first section describes the sub-statement components such as literals and expressions. The second section covers the statements (program operators) that can be composed from these sub-statement components.

ioExample Language Definition

### Lexical and Data Expressions

The sub-statement lexical and syntactic expressions.

In ioExample, variables have their typical meaning: representing a named unit of data that can have a varying value.

A variable name is an unquoted string of alphanumeric characters starting with an alphabetic character. Examples of variables are VarA, LoanAmount, and InterestRate5.

Literals have their typical meaning in ioExample: they represent a specific unalterable value in a particular data type.

There are two data types in ioExample: Code and Numeric. Correspondingly, there are two data types of data literals, one for each type.

For the Code type, a literal is a single quoted alphanumeric string. Examples of Code literals are ‘a’, ‘overdrawn’, and ‘late30’.

For the Numeric data type, literals take the form Real number. Examples of Numeric literals are 100, 24.67, −0.58.

Expressions and Operators

Expressions are the phrases in computer languages. They are themselves not complete statements, but they combine lexical units into more complex structures.

In ioExample, expressions are focused on data types, Numeric and Code. Each data type can be used in two types of expressions: calculation expressions that result in a value with the same data type, and comparison expressions that result in a Boolean true or false.

Expressions naturally have operators that define how the elements of the expression are to be combined. These, too, are included below.

Numeric Calculation Expressions and Operators

The form of a Numeric Calculation expression is as follows:

VarA*NumericLiteral+VarB*NumericLiteral . . . +ProcedureCallA*NumercLiteral+ProcedureCallA*NumercLiteral . . . +NumericLiteral

This form is, in essence, a linear algebraic equation with N variables, commonly found in freshman high school mathematics classes. The meaning of these expressions is precisely that learned in high school.

It will suffice to make a few additional comments about this type of expression:
The expression can have N variables, that is to say, the number of variables that participate is 0 or more. As is illustrated, each variable is paired with a numeric literal that, in mathematics, is called a coefficient.
The expression can “call” numeric procedures that have been defined in the system. Numeric Procedure Calls are defined below in the program operator's section, but have their common meaning. There can be 0 or more procedure calls.
There can be one of more numeric literals in the expression.
All the elements (variables, literals, and procedure calls) are linked by addition or subtraction operations. Any “+” in the form above can be replaced with a “−.” This is the nature of a linear algebra, and a deliberate constraint in this language.
Multiplication and division only take a role in relating a coefficient to a variable or procedure call.
Any “*” in the form above can be replaced with a “/.”

Examples of Numeric Calculation expressions are:

NewRate*10+Rate*5+3

NewRate*10−Rate*5+CalcToday(3)−3

Rate*5+3

Rate

Numeric Comparison Expression and Operators

A Numeric Comparison Expression compares two numeric expressions using a Boolean operator and decides whether the Expression is true or false. These expressions are used typically as the “test” in an if-then-else conditional statement.

The syntax of the expression is as follows:

NumericExpressionA<NumericBooleanOperator> NumericExpressionA

A couple of comments about this form:
1. Numeric Expression is any valid Numeric Calculation Expression as defined above.
2. Numeric Boolean Operators must be one of the following:
   >=
   <=
   !=
   >
   <
   =
3. The semantics of the operators are their common ones.

Examples of Numeric Comparison Expressions are:

“X+5<Y−3”

NewRate*10+Rate*5+3=NewRate*10+Rate*5+3

Code Calculation Expression

The form of a Code Calculation expression is any of the following
CodeLiteral,
CodeVariable, or
CodeProcedureCall

CodeLiteral is defined above. CodeVariable and CodeProcedureCall are defined in the program operator section below, but have their common meaning.

Code Comparison Expression

A Code Comparison Expression, as with numerics, compares two Code expressions, using a Boolean operator, and decides whether the Expression is true or false. These expressions are used typically as the “test” in an if-then-else conditional statement.

The syntactic form of the expression is:

<CodeExpression> <CodeBooleanOperator> <CodeExpression>

A couple of comments about this form:
The Code Expressions are any valid Code Calculation Expression as defined above.
The Code Boolean Operators must be one of the following:
   =
   !=

Program Operators/Statements

The program operators (statements) in the ioExample language.

Program operators or program statements are the grist used by programmers to define algorithms; they are literally the steps of the algorithm. These types of operators are almost universal in mainstream computer languages. There is no reason to belabor their definition; their semantics will only be informally described.

Statements and Statement Blocks

The common syntax associated with statements is:
All program operator statements are terminated by a semi-colon (;), or are terminated in some cases by a statement block enclosed in curly brackets “{ . . . }”

A Statement Block is a series of zero or more correctly formatted program statements. Statement blocks are a construct that groups a series of statements together as an execution unit. Statement blocks are used typically in procedure definitions and conditional definitions.

Variable Declaration

Variable declarations define data and make it available to the program operators. The declaration makes a variable-name specifically associated with a unit instance of a data type. Variables are valid only if declared before use.

In the case of ioExample, the unit instance is either a Numeric or a Code. In the case of a Numeric instance, one can assume that it is a floating-point approximation of a Real number. In the case of Code instance, the instance is a pointer (to a string of characters).

The syntactic forms of the variable declarations are
Code <VariableName>;
Number <VariableName>;

Obviously variable refers to the definition above.

Examples of declarations are:
Code AccountStatus;
Numeric Interestate.

Assignment

The assignment operator is used to set the value of a variable to an appropriate expression; it has the same semantics commonly used in typical source languages. The value of the variable on the left is set to the value of the expression on the right.

The syntactic form of assignments is as follows.
<CodeVariable>:=<CodeExpression>
NumericVariable>:=<NumericExpression>

As is implicit, it is the responsibility of the programmer to only assign numeric expressions to numeric variables, and code expressions to code variables. Doing otherwise will typically result in a compilation error.

Examples of assignments are:
AccountStatus:=‘overdrawn’;
InterestRate:=BaseRate+0.02 (assuming BaseRate is valid)

Procedure

The procedure call operator has the typical semantics found in program languages. It invokes a procedure with the supplied arguments. The called procedure returns a value that is optionally used by the calling procedure. There are two types of references to procedures, definition and invocation (call).

The syntactic form of a procedure definition is:
<ReturnType> <ProcedureName>(<variableDefinition1>, . . . <variableDefinitionN>) <statementBlock>

This syntax is almost universal in computer languages, but for consistency:
ReturnType is either Numeric or Code. It indicates whether the procedure will return a numeric result, or a code result.
ProcedureName is the variable name identifier for the procedure that is used to invoke it. The (<variableDefinition1>, . . . <variableDefinitionN>) represents a list of argument declarations.
This list defines the data type of the positional argument that will be passed to the procedure. It also declares the name by which the argument will be referenced. The form of each argument declaration is precisely the same as that of a variable, with the exception that there are no semi-colons, merely a comma-delimited list of declarations.
The StatementBody is the series of program statements that define the algorithmic behavior of the procedure. The form of the statement body is defined above.

Then syntax of procedure invocation (call) is:
<ProcedureName>(<calculationExpression1>, . . . <calculationExpressionN>)

The syntax and meaning of a procedure invocation or call is common to almost all programming languages, but for the sake of consistency:
ProcedureName is variable name declared in the procedure declaration.
The list (<calculationExpression1>, . . . <calculationExpressionN>) contains the values that are being passed to the procedure which will be used in its algorithm. There will be a one-to-one positional correspondence between the arguments used in the invocation, and the argument variables. The value of each expression will be assigned to the corresponding argument. Obviously the data type of the argument must match. The determination of whether calculation expression is Numeric of Code is set by the corresponding argument declaration. These standards are, again, almost universal to all programming languages.

One significant restriction is imposed upon ioExample regarding the use of procedure calls. Recursion is not allowed.

Recursion in programming language allows procedures to call themselves directly or indirectly. An example of direct recursion would be a procedure that invokes itself. Indirect recursion occurs when a sub-procedure calls the parent procedure. A sub-procedure would be one called by the procedure, or called by any sub-procedure.

Conditional Flow: if-then-else

The “if-then[else]” operator has the same semantics as conditional statements in common programming languages. A sketch of the conditional program operator's behavior follows its syntactic definition.

The syntactic form of the statement is:
If (<ComparisonExpression>)<StatementBlock1> else <StatementBlock2>

The “<Comparison>” can either be a numeric comparison expression, or a code comparison expression. Both StatementBlock1 and StatementBlock2 are statement blocks as defined above.

The behavior of the conditional statement is as follows:
The Comparison is evaluated to true or false.
If true, StatementBlock1 is executed and StatementVBlock2 is skipped.
If false, StatementBlock1 is skipped and StatementBlock2 is executed.

Return

As with the other program operators, “return” has the same semantics used in common programming languages. The expression is evaluated, the current procedure is terminated, and the calculated value is returned to the calling procedure. The type of the return value (Code or Numeric) must match the type declared in the function header.

The syntactic form of Return is:
return <CalculationExpression>;
   The data type of the CalculationExpression must be consistent with the return type declared in the procedure declaration.

Example Programs

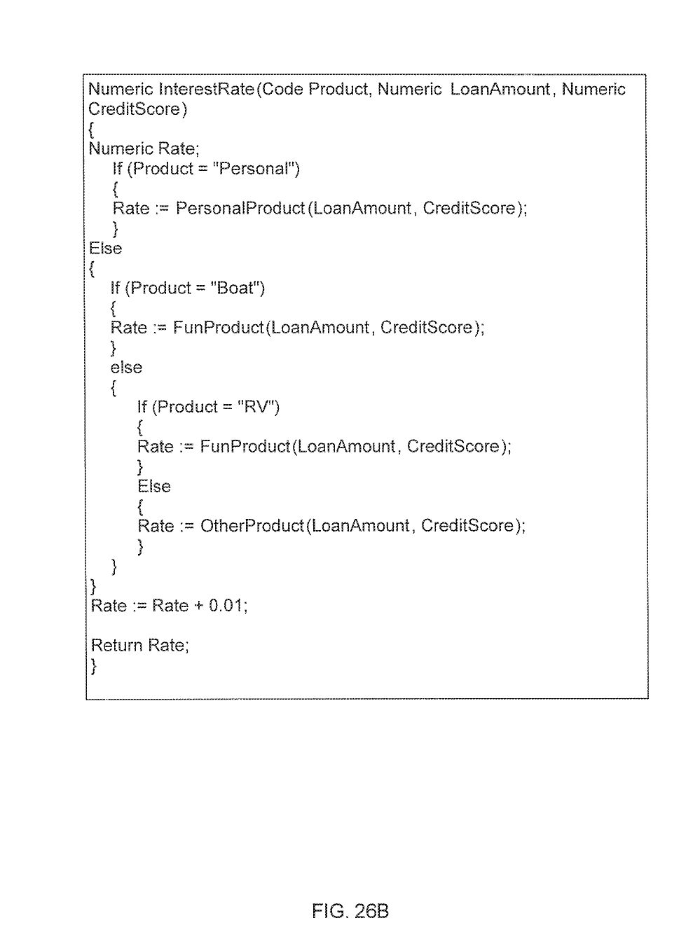

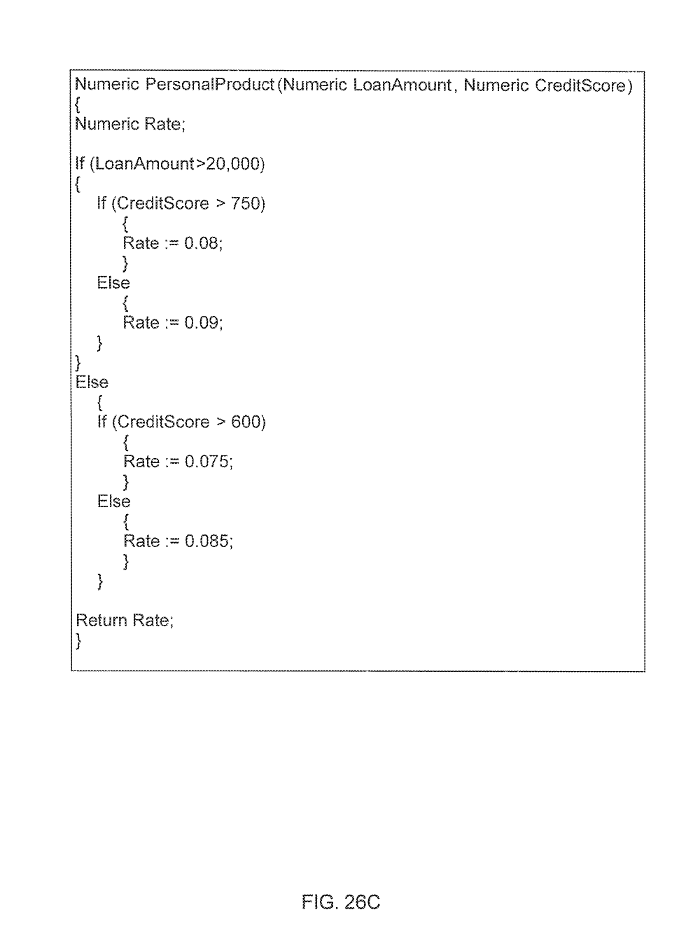

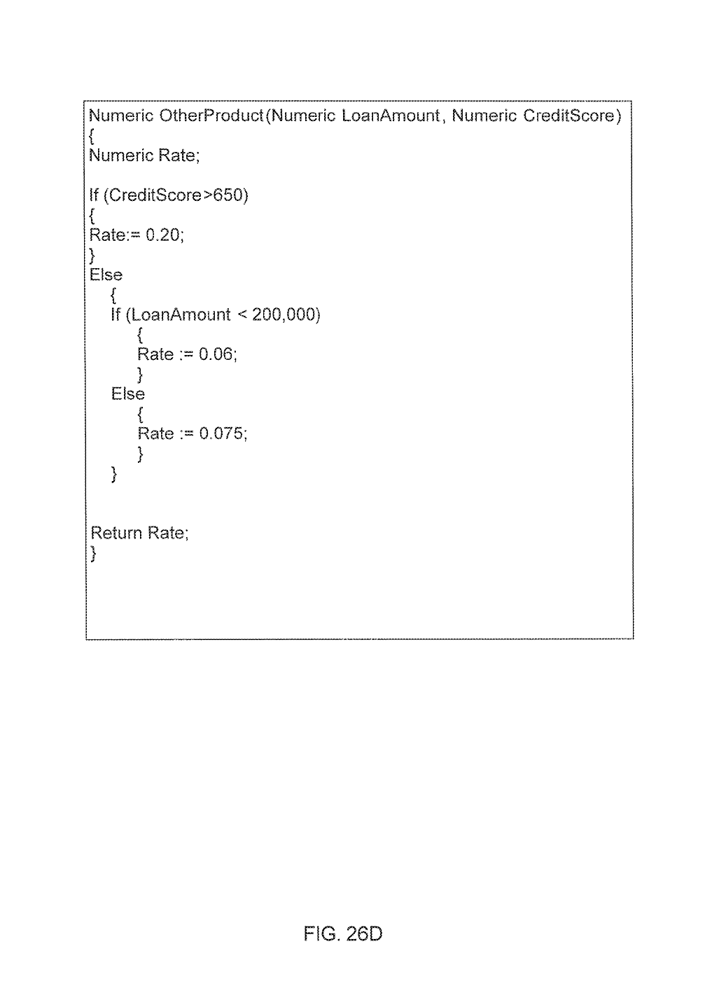

FIGS. 26A-26D illustrates several programs, which together constitute the example system that is carried through the entire FIOSM generation processes described below.

Definition of System

Speaking informally, business develops “systems” that are composed of a set of individual program procedures. Typically, when programmers write a system, it is composed of many procedures. These procedures might be written in one language, or in many languages. The programmer might write them all; or some may be “libraries” purchased from other software developers.

Speaking more formally, in this Concrete Example and with the language ioExample, a system is defined as a finite set of procedures written by programmers, such that:
There is an “entry point” for the system that is defined as the first procedure invoked; this first procedure must be a member in the set.
The set must be closed in regard to procedure calls. This is equivalent to saying that any procedure invoked (called) must be a member in the set.
   As with other ioExample constructs, this is a common approach in computer science to defining a “system.”

Examples

FIGS. 26A-26D show an example of an ioExample system named InterestRate, which calculates the interest for loan products.

The system contains four program procedures: InterestRate, FunProduct, PersonalProduct, and OtherProduct. The entry point is designated as InterestRate. This example also illustrates procedures in which the components described above are composed together. The InterestRate system will be used throughout the remainder of the Concrete Example, to show the actions and results of the various processes.

FIOSM Definition

Having defined the computer language, following the process described above, the next step is to define the semantic model (FIOSM).

This step itself is broken into several exemplary sub-activities:
The definition of the input and output;
The definition of data expressions;
The definition of patterns, and
The definition of the model itself.

Input-Output Definition

One of the first decisions that must be made in the definition of the FIOSM is the definition of input and output. This embodiment takes a simple definition of input and output:
Procedure arguments are input
Procedure return values are output

This decision is consistent with ventures that intend to develop programmer productivity tools, or quality assurance tools to be used internally by an IT group.

Data Expressions

In the model, every data type must have a data expression format that can express the possible values of the model. The background and terminology in this section are developed above. In ioExample, there are two data types for which data expressions must be defined, for the Code data type, and for the Numeric data type. Each of these is discussed below.

Code Data Type

The Code data type is an enumerable data type. Consequently its data expression takes the form:

<data element name> <CodeBooleanOperator> <code literal>[AND <data element name>
<CodeBooleanOperator> <code literal>],

Data element name has its common meaning and is discussed above. Code literal is defined in the Language Specification Guidelines above.

An example of a Code data expression is:

Loan_Type=‘auto’

A second example using the optional second clause would be:
Loan_Type !=‘auto’ AND Loan_Type !=‘boat’

Numeric Data Type

The Numeric data type is a non-enumerable data type. Consequently, it needs to have a finite lexical expression to describe an infinite set. Consistent with the examples in the detail section, the common form of numeric expression used in academics and industry is adopted here. Both the Detailed Description and the language section above develop this in detail.

The input data expression takes the form of:

<data element name1> <Numeric Boolean Operator> <Numeric Literal>[AND <data element
name1> <Numeric Boolean Operator> <Numeric Literal>]

Data Element Name is defined above, and corresponds to variable name in this exemplary embodiment. Numeric Boolean Operators are defined above in the language definition section in the context of Numeric Comparison Expressions. Numeric Literal is defined above in the language definition section discussing literals.

Note that the square brackets denote a second optional expression. One example of data expression would be:
Interest_rate <0.70

A second example using the optional second clause would be:
Interest_rate <0.07 AND Interest_Rate >0.01

Defining a Pattern

The Input-Output Pattern of Data expression (IOPD) used in this FIOSM is defined precisely above.

Defining a Model

The Input-Output Semantic Model used is defined above.

ioExample Language Features and Completeness

As described, a language that is “correct and complete” in regard to generating a finite input-output semantic model (FIOS Language) must satisfy two criteria:
Code Path property, and
Data Flow.property

These characteristics are discussed generally above. The following sections address these requirements and demonstrate that ioExample conforms to these requirements. Further, the process surfaces the algorithms that may be used in the generation of the semantic model (FIOSM) itself.

Finite Code Path Requirement

The finite Code Path property states that for any program written in a FIOSM language, the program must contain only finite code paths. Further, there must be a complete and correct algorithm for generating the Code Path Model for any program written in the language.

This example introduces a method of demonstrating how ioExample and a large family of related languages can be shown to be consistent with the Finite Code Path quality. This demonstration involves a logical formalism called a “Tree Model” Property. This “Tree Model” property is in essence a statement that all possible path models are DAGs. Further, for any logical systems that can be shown to conform to the Tree Model property, there exists a large family of algorithms, commonly called tree search algorithms, which are commonly known to be complete and correct.

First, this section contains a discussion of a large family of languages whose code paths can be reduced to Tree Models (DAGs). Any language whose program operators can be represented as DAGs, and that has rules of composition consistent with those described, will in fact have the Finite Code Path property.

Second, this section shows how ioExample conforms to the Tree Model/DAG requirements, and therefore conforms to the Finite Code Path requirement.

Finally, the tree search algorithm used to generate the Code Path Model for any ioExample program is introduced and discussed.

All of the proofs in the section are informal, in an attempt to avoid confusion by introducing the formal language needed for formal proofs. Nevertheless, they are all clear and valid.

Finite Code Path and Tree Models

### Summary: Path Models, Direct Graphs, Tree Models

Program Code Paths that can be reduced to directed acyclic graphs (DAG) have the quality referred to in the Logic community as Tree Models. Languages that produce Path Models with the Tree Model quality satisfy the “Finite Code Path” requirement. The concepts of directed graphs and directed acyclic graphs are well known to those of average skill in the art and will be developed here only in a cursory fashion so as to focus attention on their relationship to the Finite Code Path property.

Graph Background

### Directed Graphs

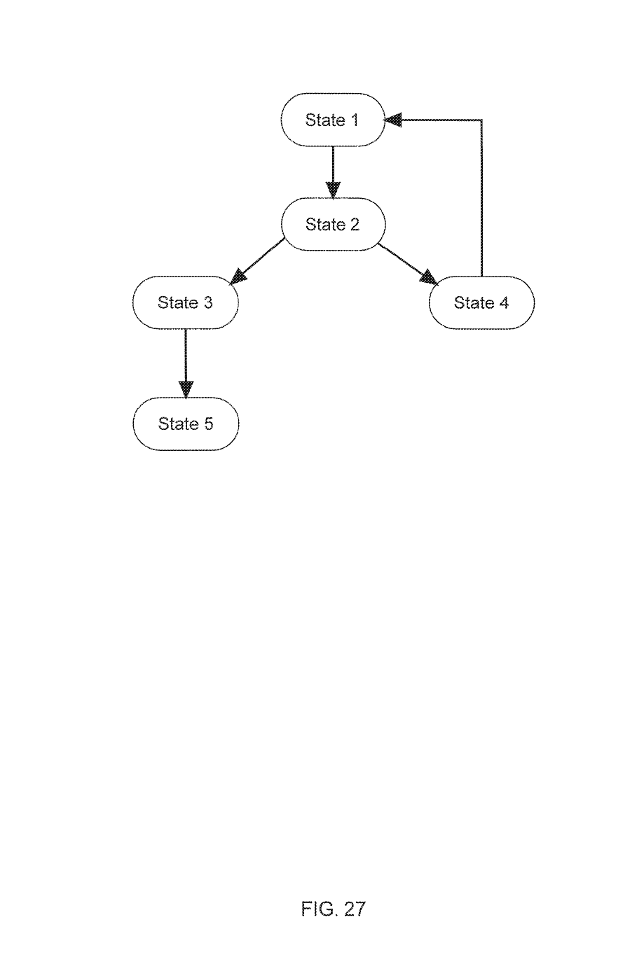

All procedural programs can be represented by the mathematical formalism “directed graphs” (DG). DGs are composed of nodes and arcs to form state-flow diagrams. An example of an arbitrary direct graph is FIG. 27.

In the context of programs, one can transform any program using the following formula:
Each program operator is composed of an entry node, a series of operation nodes, and one or mode exit nodes
The operation nodes represent the behavior of the program operator; these nodes form a path between entry nodes and exit nodes.

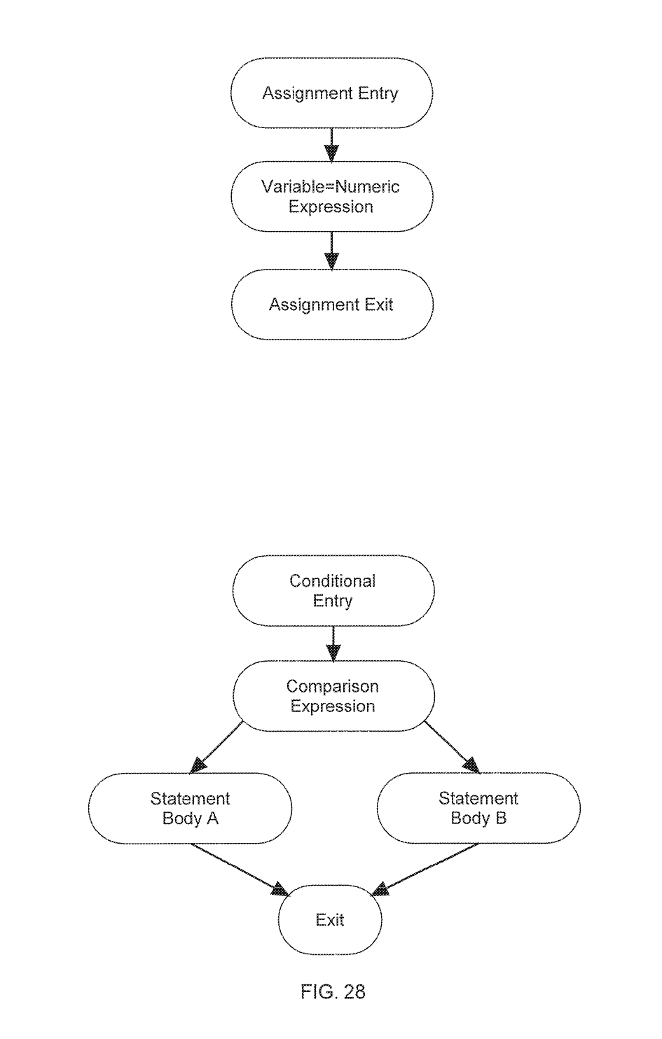

FIG. 28 illustrates two examples of program operators from the ioExample language: assignment and conditional. In the assignment example there is only one operational node: the assignment itself. The conditional program operators are slightly more complex, containing three operational nodes and a split in the directed graph, corresponding to the choice of which statement body to execute, depending on the result of the comparison.

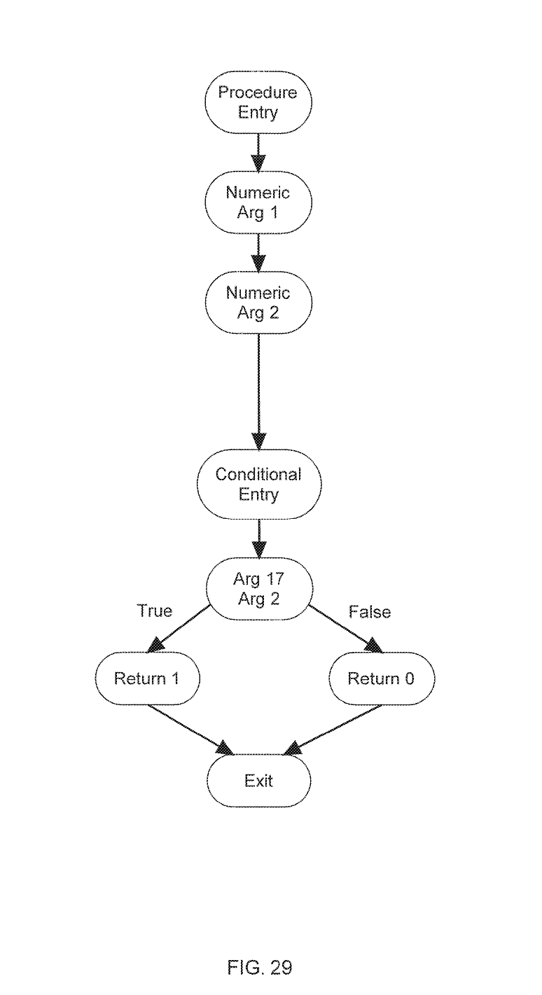

Given that all program operators are defined in this fashion, any program in a language can be composed by creating instances of program operator graphs and connecting exit nodes to entry nodes. This is precisely analogous to writing a program in text. FIG. 29 shows a simple program as a directed graph. A program typically has a start node (root node), and one or more end nodes (leaf-nodes), these represent the entry and exit points of the program. Note that in the example, the program has two implicit exit points, which are the returns in the conditional. The Nodes in between generally have a node-arc arrangement that is linear. The exception, as illustrated in the diagram, is the conditional that splits the “branch” into parallel branches that merge back together.

Directed Acyclic Graphs (DAG)

Directed Acyclic Graphs (DAGs) are directed graphs in which loops are disallowed. This corresponds to the “control changes” to previous program points. More precisely, loop in a directed graph occurs if an arc path is cyclical. That is to say, there exists a path such that, by moving forward in the direction of the arrows, eventually one can return back to the same node. Note that FIG. 29 is a directed acyclic graph.

One of the obvious properties of DAGs is that in walking the graph in the direction of the arrows, one only passes any specific node but once. This is, in fact, the mathematical definition of a DAG.

Acyclic Composition of DAGs Produces DAGs

One property of DAGs is that if one composes them, the result is also a DAG. By composition, one means: given two DAGs, adding an arc between the exit node in one graph to an entry node in the other graph produces a “composed” graph. This composed graph is always a DAG. It is straightforward to prove that this is true, in brief as follows.

Given:

There are two separate DAGs (DAGa and DAGb) that are composed in the following fashion: For every exit node in DAGa, add an arc to every entry node in DAGb. Otherwise the structure of the graphs is unchanged.

### Then:

The composed graph is a DAG.

### Proof:

Assume the contradiction that the result is NOT a DAG. This would imply that there was a loop in the graph. But both graphs are DAGs so there cannot be a loop “internal” to either. Otherwise, it would contradict the premise that they are both DAGs. In addition, the added arcs between the graphs are uni-directional, so there cannot be a loop between the graphs. Thus the existence of a loop is inconsistent with the assumptions.

Directed Acyclic Graphs and Finite Code Path

Programs that produce finite DAGs have the finite code path property. This is the connection between DAGs and finite code paths. Computer programs and systems produce directed graphs with a finite number of nodes. This is easy to understand since any program has a finite set of program operators in it, and each program operator produces a graph with a finite number of nodes.

If a programming language can produce only finite DAGs, then it conforms to the Finite Code path property. If it were otherwise, then there would have to be at least one node visited an infinite number of times. This would be a contradiction to the definition of a DAG.

DAG and Languages

Languages in which all programs can be shown to be equivalent to finite DAGs are compliant with Finite Code Path requirement. Demonstrating that a language produces only programs equivalent to DAGs is straightforward and described below.

It is sufficient that a programming language has two qualities that:
all program operators can be represented by finite DAGs, and
the rules of composition are consistent with those described above in the section “Acyclic Composition of DAGs Produces Finite DAGs.”
   Since every single possible program in a language has a one-to-one correspondence to a finite DAG, the set of all possible programs in a language is covered. More formally in mathematics, this demonstration corresponds to a proof by induction. This informal proof summarizes the induction proof.

Practical Application: ioExample

This DAG/Tree Model approach to demonstrating conformance to the Finite Code Path criterion can be used in many computer languages, including ioExample. The first step is to show that all program operators can be expressed as DAGs, For ioExample:
Declaration: A declaration is merely a three-node graph consisting of an entry node, an operation node that contains the declaration, and an exit node.
Assignment: An assignment, like a declaration, is merely a three-node graph consisting of an entry node, an operation node that contains the assignment, and an exit node.
Statement Block: A statement block produces a graph with an entry node at the beginning, and an exit node at the end, and a sequence of an arbitrary number of acyclically composed program operator graphs between the two. If each subordinate program operator graph is a DAG, then the result must also be a DAG. Thus, for statement block, one can state: if all other program operators can be shown to correspond to a DAG, then Statement Block is a DAG.
Conditional: Conditionals produce a graph of the form shown in one of the earlier examples (FIG. 28), only abstracted to the general case. Obviously, the example in FIG. 28 is a DAG. In the general case, nodes in the fork are actually statement blocks. As discussed above, statement blocks are DAGs if all other operators are DAGs. So if that condition is satisfied, then “condition” must be a DAG as well.
Procedure Definition: A procedure definition can be represented as an acyclic composition of an arbitrary number of Argument Declaration DAGs, and a statement body DAG. Since all the sub-graphs are DAGs, Procedure definition will be as well.
Procedure Call: Procedure call is in essence using an instance of the Procedure Definition; thus it is a DAG.
   The second step is acyclic composition. This is obviously satisfied in ioExample; there is no other way to compose the programs other than by one program operator to the next. Having shown how ioExample satisfies the two criteria, we may conclude that ioExample satisfies the Finite Code Path requirement.

Broader Application: Tree Model and Recursion

There are many FIOSM non-compliant languages in computer science; in fact the mainstream majority are not compliant. In the larger family of languages, recursive procedure calls and loops are problematic. ioExample avoids this challenge by forbidding recursion. An infinite recursion would create an infinite DAG and would violate the assumptions. Any programming language with general recursion (or “gotos” or “general loops”) is not able to generate a semantic model. General recursion is a requisite assumption of the Turing “Halting Problem” proof. Any language to which the Turing proof is applicable will not conform to the Finite Code Path. The process described in this filing describes how to circumvent the assumptions of Turing's proof by requiring that Finite Code Path requirement be satisfied.

Recursion in itself does not mean that a language is non-compliant, just that the recursion must be limited, and the proofs of Finite Code Path may be more elaborate. The Tree Model quality can apply to a broader set of languages than those represented by simple DAGs, including languages with recursion. It is possible to have a language that has the Tree Model quality and limited recursion; this type of language would also satisfy the Finite Code Path quality.

Tree Search and Tableau Algorithm

The Tree Model and Directed Acyclic Graph (DAG) structure also facilitates the selection of a complete and correct algorithm for identifying all possible paths through a language's set of programs.

Computer Science and Artificial Intelligence have identified a family of algorithms that can be used to search DAGs (or Tree Models). This family of algorithms is called “Tree Search Algorithms.” These have been identified as complete and correct for more than thirty years, and are typically taught on an undergraduate level in “algorithm” classes. This exemplary embodiment uses one such technique or algorithm, named “Tableau,” to search for valid paths in an arbitrary ioExample program. The specifics are left to the generation section that follows.

Decidable Data Flow

The second of the two criteria that a computer language must satisfy to be able to generate a semantic model (FIOSM) is Decidable Data Flow. This section discusses this criterion in the context of the ioExample computer language. Further, as was done with the Finite Code Path criterion, it offers techniques and approaches that address a broader family of computer languages than only ioExample.

To build a semantic model, one must be able to employ a correct and complete algorithm that determines the values of all data elements, at every state of a program's execution. This allows one then to generate an input-output model as described in the previous section above.

Above, the satisfaction of the Decidable Data Flow criterion is defined as equivalent to establishing an algorithm or group of algorithms that can determine every data element's value with:
Completeness,
Correctness, and
Ability to detect incorrectness.

This section introduces an algorithm, Fourier Elimination, which can be used to satisfy the Decidable Data Flow criterion for both Numeric and Code data types. In the case of the Numeric data type, Fourier Elimination is established directly as satisfying Decidable Data Flow. In the case of the Code data type, the Code data type is “reduced” to the Numeric case, demonstrating that Fourier Elimination satisfies Decidable Data Flow for Code, as well.

The next two sections discuss this in detail, addressing sequentially the Numeric Data Type, and the Code data type.

Numeric Data Type

The Numeric data type is limited to linear numeric expressions, and consequently the Fourier Elimination algorithm can satisfy Data Flow decidability. There are a variety of algorithms (Fourier Elimination, Gaussian Elimination, Simplex, to name a few) that are commonly acknowledged and long demonstrated to be correct and complete for linear equations and inequalities. The one employed in this example is Fourier Elimination. It is the same algorithm taught in high school to solve all linear equations encountered in first year algebra.

Using a Fourier Elimination algorithm, any data element can be resolved to its data element value as defined above in the semantic model definition section. The actual algorithm is detailed later in this example in the section explaining model generation.

To satisfy Decidable Data Flow, Fourier Elimination must satisfy the three criteria:
Completeness: The completeness of Fourier Elimination for numeric expressions limited to linear equalities and inequalities has been common knowledge for almost 200 years.
Correctness: Like completeness, the correctness of the Fourier Elimination for numeric expressions limited to linear equalities and inequalities is demonstrated and well known.
Detection of Incorrectness: Fourier Elimination is an algorithm that proceeds by isolation of a variable (data elements in our case), and then elimination. Upon the elimination of all variables, there remain only literal equalities and inequalities. If any single literal expression is invalid, then the original set of expressions is also invalid. This feature of the algorithm thus satisfies the requirement that it can detect incorrectness, or invalidity. The discussion of Fourier Elimination can be reviewed in mathematics texts, Constraint Programming texts, and on the World Wide Web.

Code Data Type

The Code data type and its expressions can be reduced to linear Numeric expressions, and, therefore, Fourier Elimination can satisfy its Data Flow Decidability, as well. “Reduction” is a common procedure in mathematics used to proof methods. When employing reduction, one takes an established proof, and transforms a new candidate theorem into the theorem previously validate by the established proof. The formal process of doing this is to establish a procedure of translating, without loss of validity. That is to say, every valid expression in the candidate theorem that is translated will be also valid in its new form.

The reduction procedure for Code merely translates every Code expression into a Numeric Expression compatible with Fourier Elimination. And since Fourier Elimination is valid for Numeric, it follows that the combination of the translation and Fourier Elimination will also be valid for Code.

The process for reduction is illustrated in detail in the Model Generation section below, but the gist is quite simple, and is as follows, for all Code data expressions:
Replace all Code data elements with Numeric data elements with the same name;
Since there a finite code literal in any finite program, replace each unique code literal with a single unique integer;
Replace all code operators (=, !=) with their corresponding numeric operators (=, !=)
   The result of this procedure is a set of numeric equality and inequality expressions whose Data Flow decidability can be decided by Fourier Elimination. Similarly, completeness, correctness, and deciding incorrectness are inherited with Fourier Elimination.

The illustration of “reduction” is important in the context of the broader family of computer languages because the technique demonstrates how dissimilar data types can share Data Flow algorithms and simplify the implementation of semantic model generation.

Generating the FIOSM

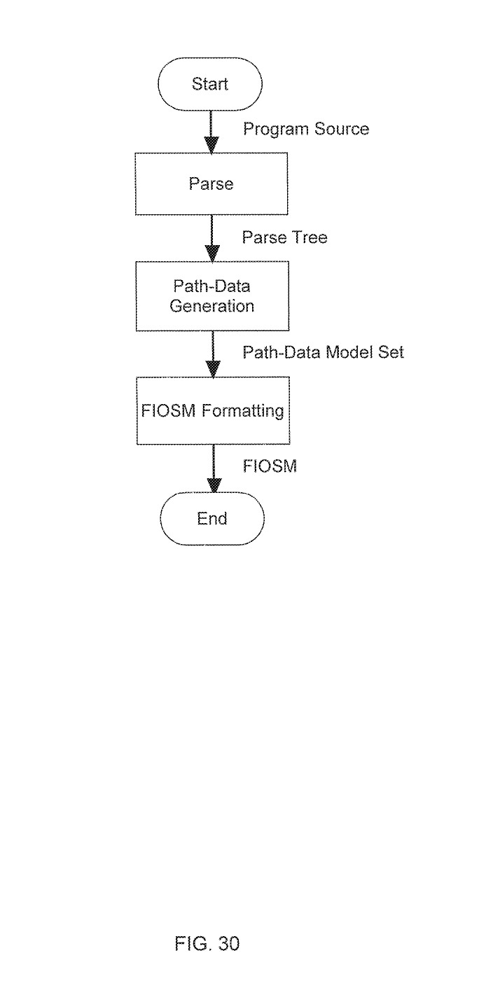

The Model Generation process for this embodiment is illustrated in FIG. 30. The form of the generation process fits abstractly with the process explained above, although, as discussed above, the specific concrete implementation, although comprising the same stages, is actually somewhat different. Specifically, the Tableau algorithm used in Model Generation process has the capability both to generate the Path Model and the Data Model simultaneously. This algorithmic capability results in the process used in the Embodiment collapsing Path Generation and Data Model Generation into a single process. This is reflected in FIG. 30 in comparison with FIG. 20. The high-level description of the Model Generation Process is discussed above, and is not repeated here. What follows is a detailed discussion of implementation of the model generation process for each phase illustrated in diagram FIG. 30:
Parse to Intermediate Form,
Path-Data Model Generation, and
FIOSM Formatting.

Parse to Intermediate Form

The Parse process takes a computer system and transforms it into an intermediate representation called a “parse tree.” A parse tree is a directed representation that eases the syntactic analysis, and consequently eases the semantic analysis in the next stage of model generation. The advantage that the graph structure offers is that it explicitly reflects the execution structure of the program.

The input to this process is the System, as defined above, that is to say, a set of source programs with a defined entry point. The output is a system in which the elements of the set are parse trees. The essence of parsing is to transform text into a tree-like directed graph. This graph structure allows other programs to easily analyze the internal structures of a program. For the purposes of this example, there is generally a one-to-one correspondence between input source statements, and graph structure.

Parsing and parse trees are such elementary processes and structures are well known to those of average skill in the art, and elaboration of this phase is not necessary for disclosure of the unique aspects of the overall invention.

Representation

The two main representational structures correspond to the computer source and the corresponding tree, or directed acyclic graph structure. The ioExample source language is defined above. The structure of a parse tree is a tree-form directed graph, where the features of each source procedure are reflected in the graph. Each procedure has a similar structure, where:
The procedure name and return type is the root node; and the root node always has two child nodes: Arguments and Body.
The argument node has all argument declarations as child nodes.
The Body node has a graph structure of the procedure's statements.

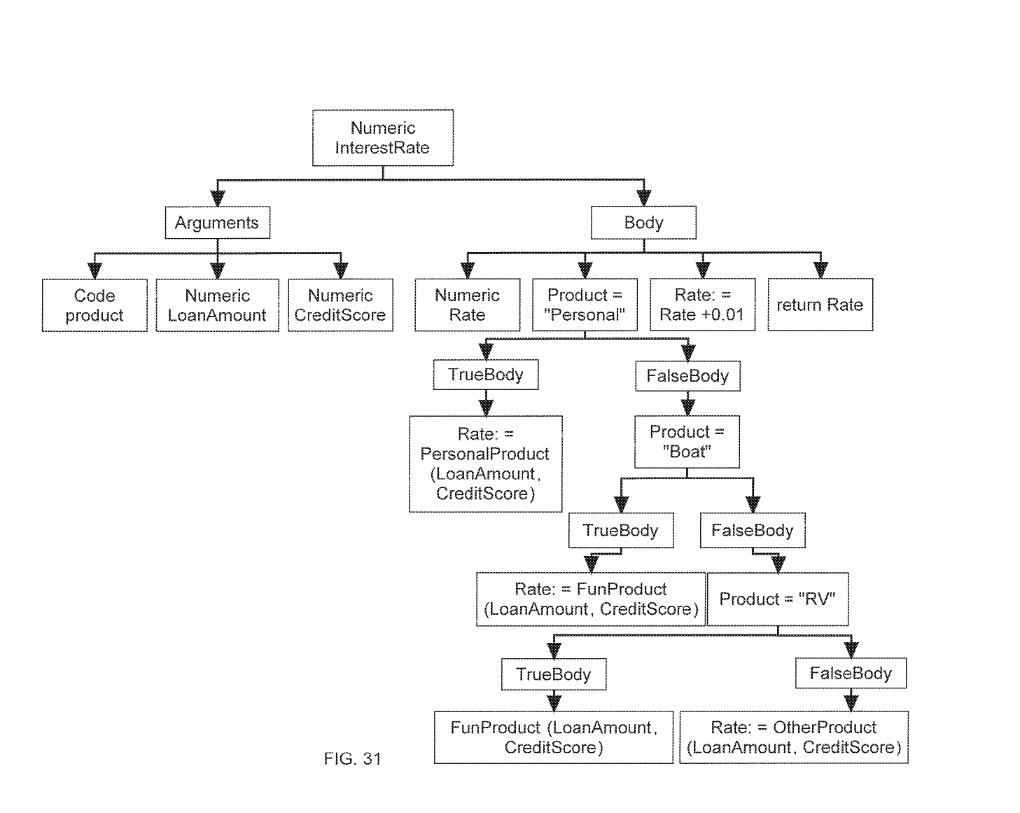

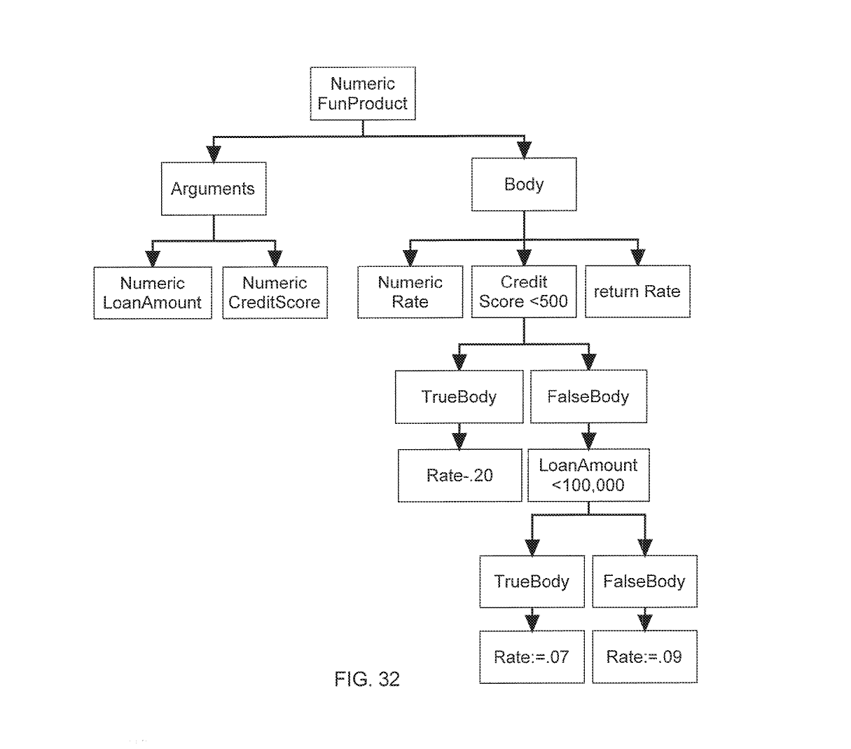

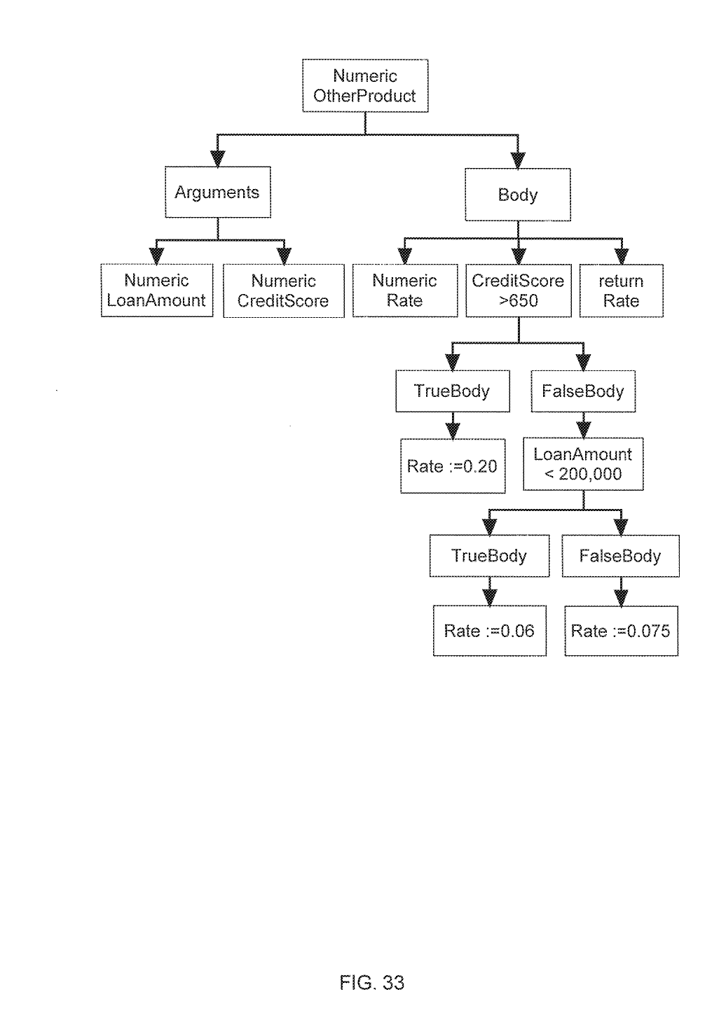

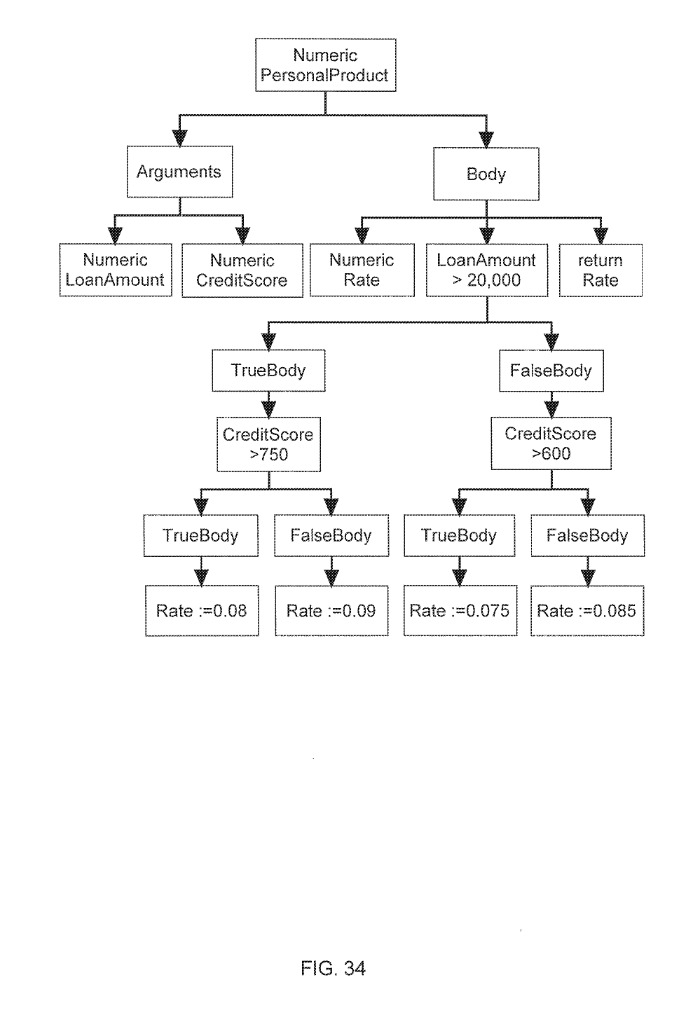

The graphs structure of the four procedures in the example system is shown in FIG. 31 (InterestRate), FIG. 32 (FunProduct), FIG. 33 (OtherProducts), and FIG. 34 (PersonalProduct). The Body section graphically captures the execution structure of the programs. The tree is executed depth-first, left-to-right. In other words, the children of Body are executed left-to-right. If any children have children themselves, then those grandchildren are executed left-to-right. This priority of “execute the children first” applies to an arbitrary depth.

A parsed system is includes:
A set in which the name and entry-point is copied from the source system, and
A parse tree graph generated from each source procedure in the source system

In the case of the example system, the parsed system would be:
A set named InterestRate with Entry-Point InterestRate
And the elements would be FIG. 31 (InterestRate), FIG. 32 (FunProduct), FIG. 33 (OtherProducts), and FIG. 34 (PersonalProduct).

Process

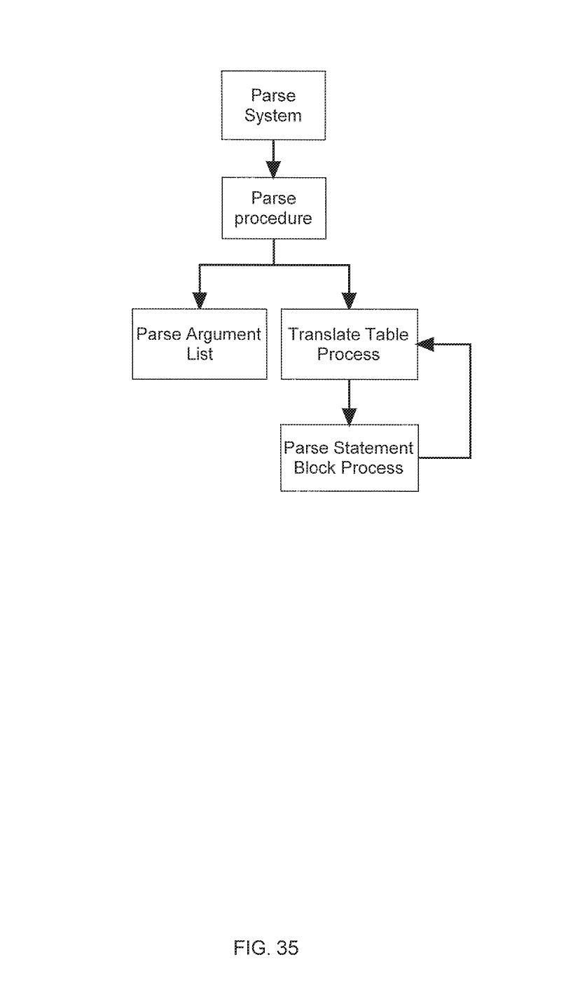

The process of creating a parsed system is comprised of a hierarchical family of processes, the highest of which, of course, is the Parse System process. FIG. 35 shows the hierarchical relationship of the processes discussed in this section

In all of the exemplary processes described herein:
An expression contained in angle brackets, for example, <returnType ProcedureName>, refers to text that is extracted from the area of the source program being parsed. It is, in essence, a variable referring to a syntactic structure in the source program. By and large these are self-explanatory. Arcs are created in left-to-right order from node.
Input values are defined in the text, but are implicit in the graphs

Parse System

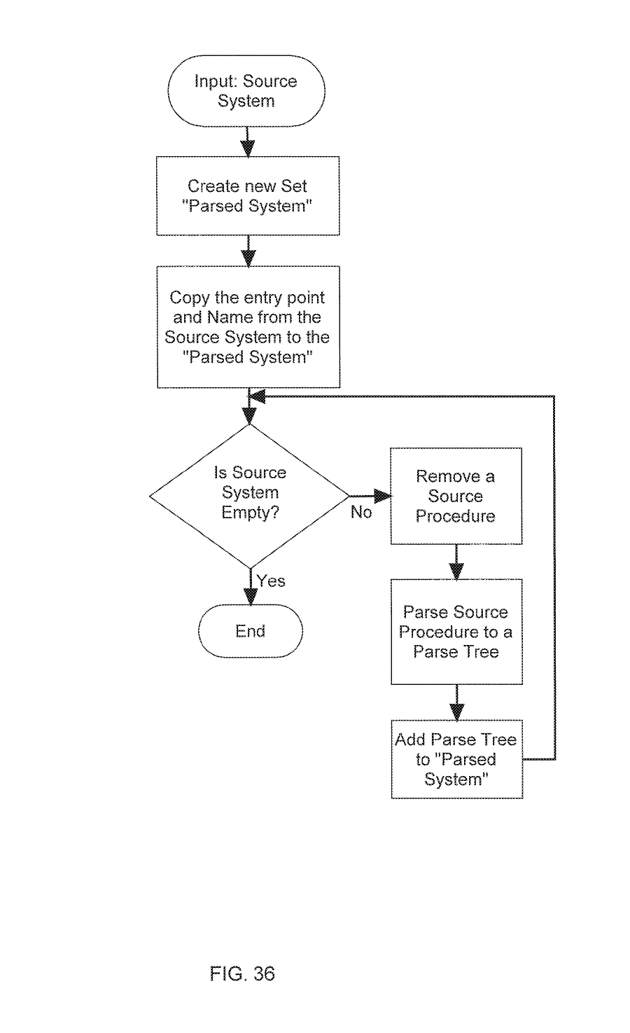

The process of creating a parsed system is illustrated in FIG. 36. This process is straightforward. Accepting the input of the Source System, the results will be a parsed system. The gist of the process is to parse every source procedure in the source system and add it to the parsed system. In the example system of Interest Rate, the input and result is exactly that discussed in the representation section above:
A set named InterestRate with Entry-Point InterestRate
And the elements would be FIG. 31 (InterestRate), FIG. 32 (FunProduct), FIG. 33 (OtherProducts), and FIG. 34 (PersonalProduct).

Parse Procedure

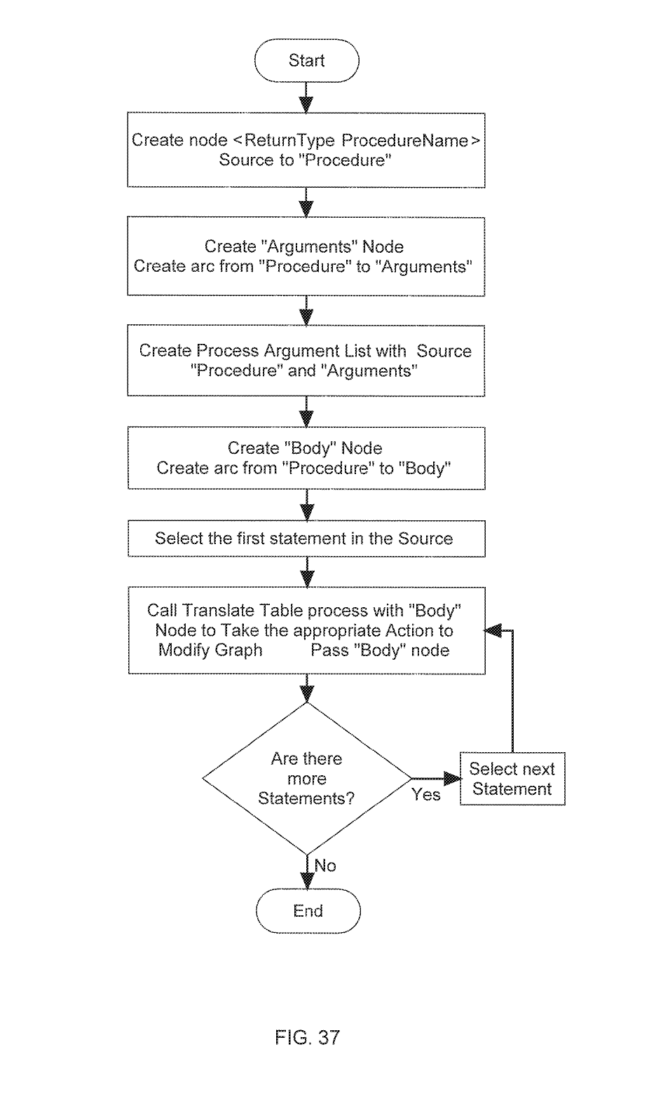

Parse Procedure is responsible for translating a source procedure into a graph structure. The input into this process is the source definition of a procedure. The output from the process is a parse tree directed graph. FIG. 37 illustrates the process. The process creates the root node for the procedure, and each of its children “Arguments” and “Body.” It calls ParseArgumentList with “arguments” and the source definition to complete the argument sub-graph. It then iterates through the statements in the procedure body, repeatedly calling Translate Table Process with the Body Node and the selected statement. This completes the body sub-graph.

Parse Argument List

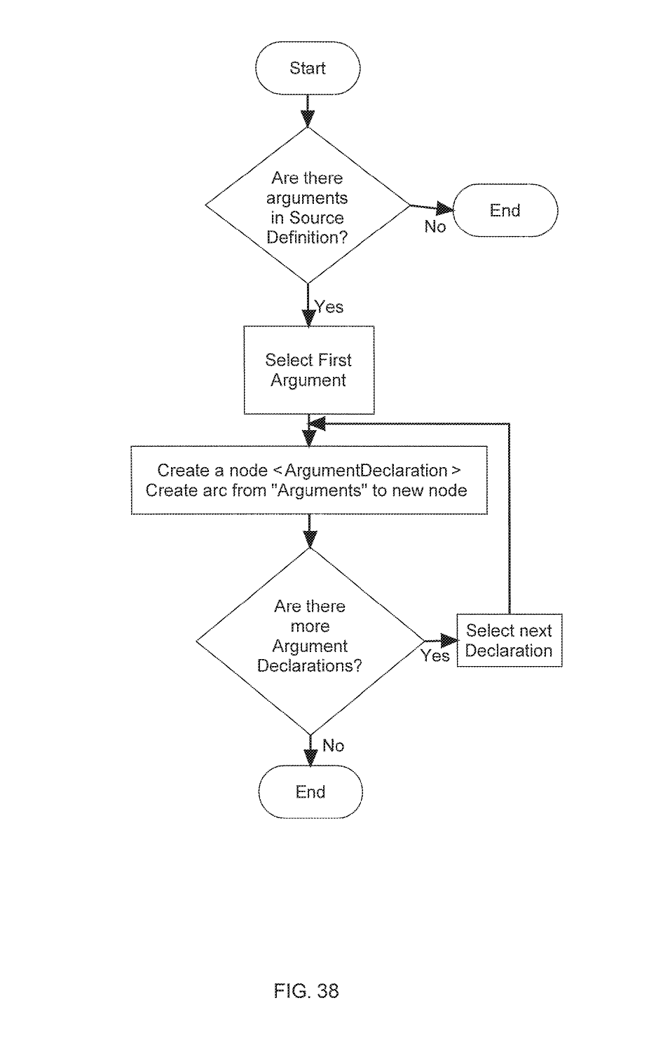

The Parse argument list process accepts the “arguments” node and the source definition as input, and has the effect of adding the argument declarations left-to-right. The process is illustrated in FIG. 38. It simply iterates through the arguments and creates child nodes to “Arguments.”

Translate Table Process

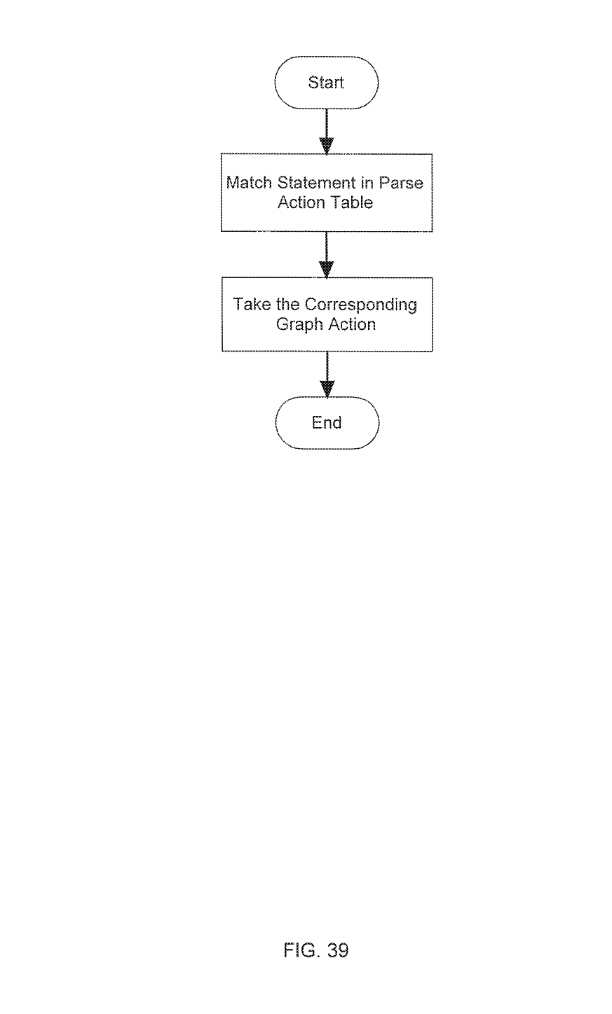

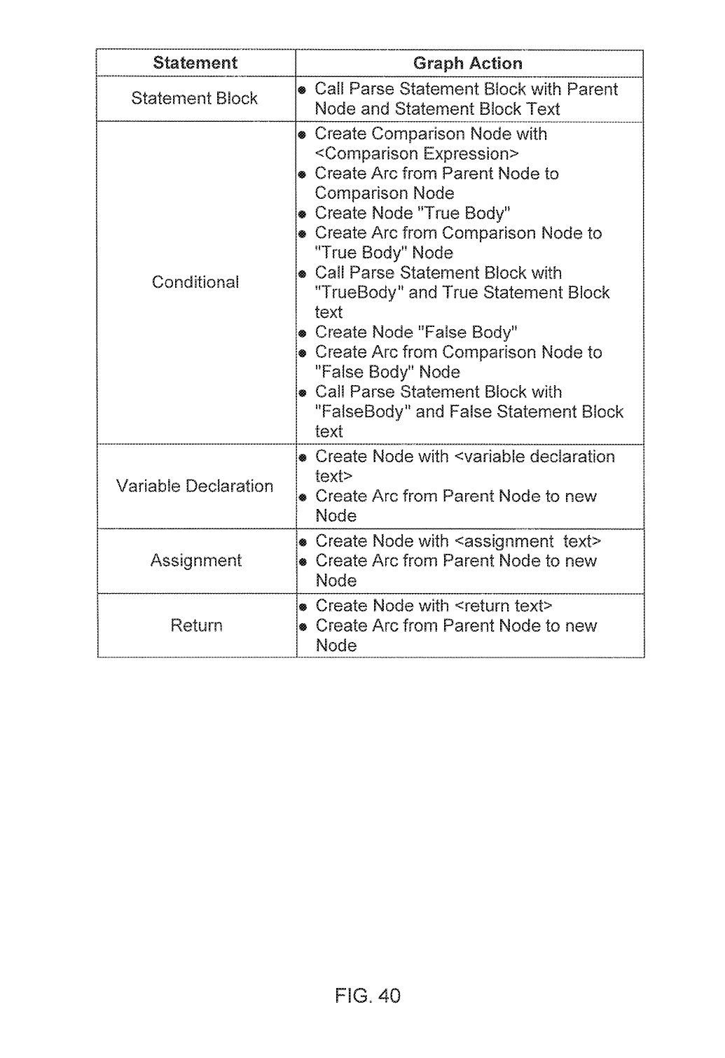

The Translate Table Process accepts a source statement and a parent node as input. Its responsibility is to syntactically recognize the source statement, and to attach the corresponding sub-graph to the parent node. The process is illustrated in diagram FIG. 39. Central to this process is the syntactic recognition of the source statement, something straightforward in parser technology. The Parse Action Table is defined in FIG. 40.

It is worthwhile to note that this process is called recursively with different parent nodes, as is illustrated in the Parse Statement Block process below.

Parse Statement Block Process

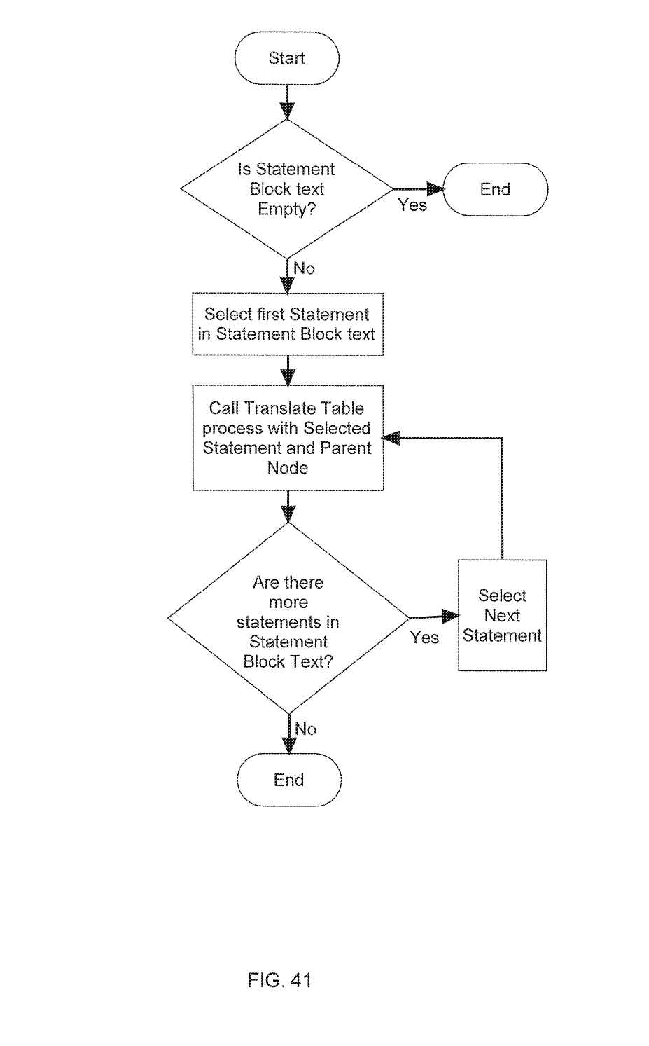

The Parse Statement Block process is responsible for creating a sub-graph corresponding to a source statement block. It accepts the statement block text and a parent node as input. FIG. 41 illustrates the process, which simply iterates through the statements and invokes the Translate Table Process for each statement.

Example

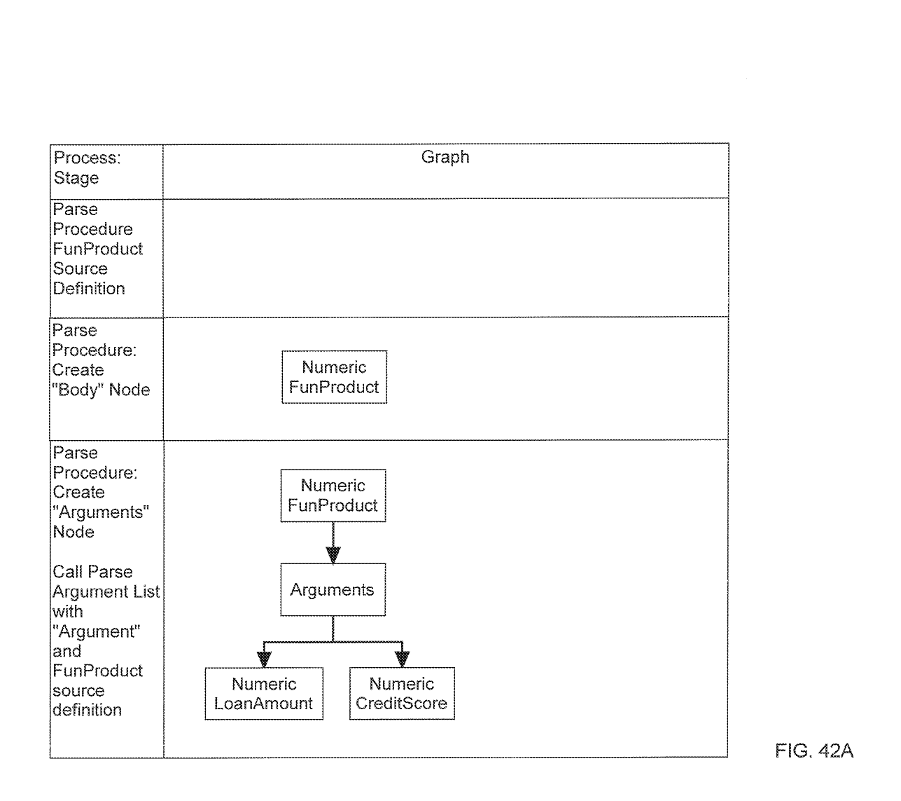

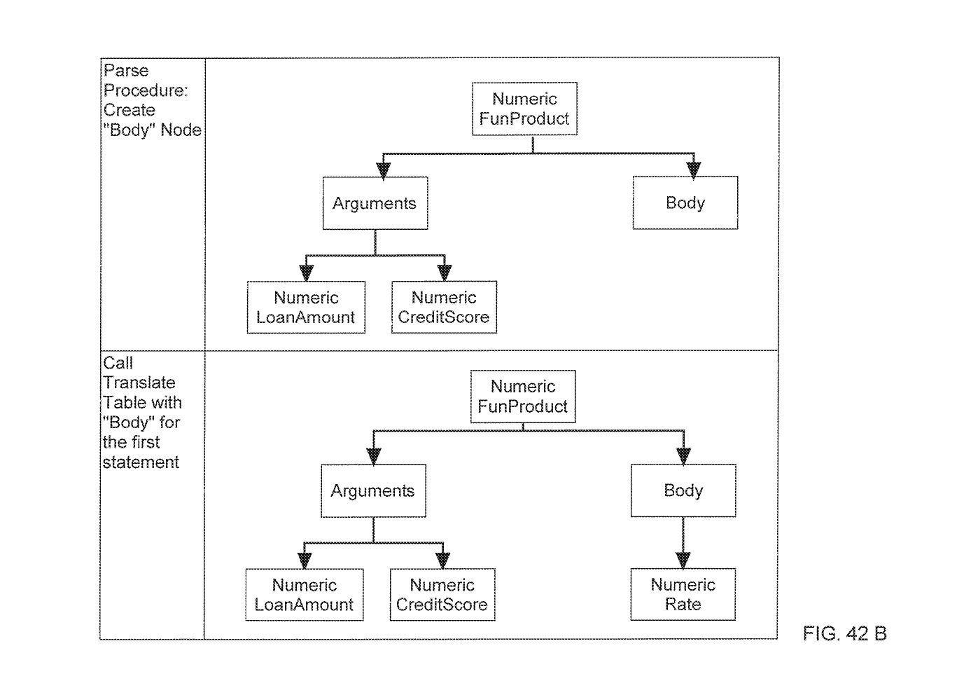

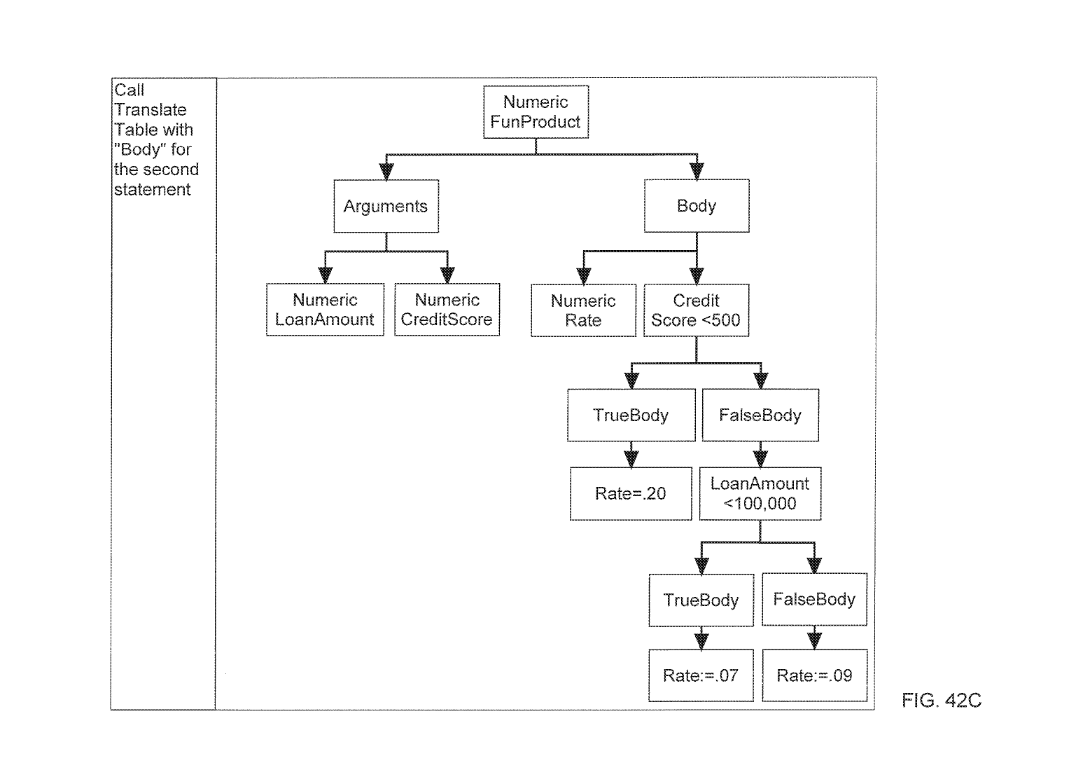

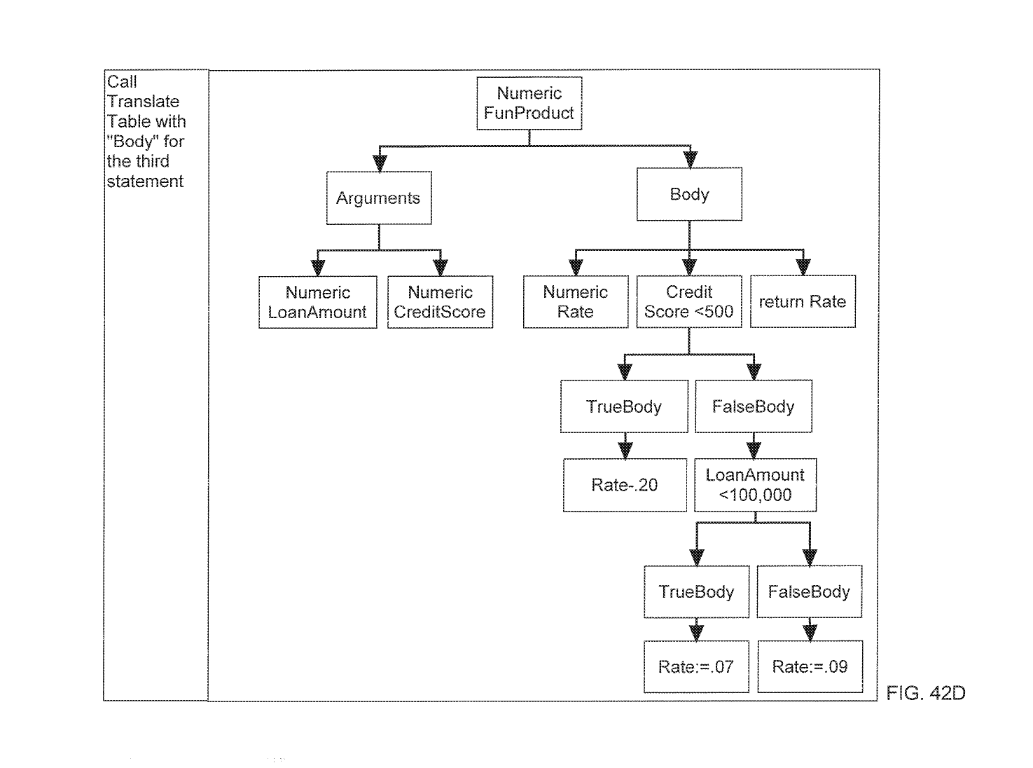

FIGS. 42A-42D illustrate the building of the parse tree for procedure FunProduct. It shows the stage of the parse procedure process on the left side, and the corresponding graph as it is being built on the right side.

In addition to the creation of an intermediate representation of a program, parsing also typically flags language syntax errors. Examples of this error processing are not included here. It is presumed that source programs that will be basis of the semantic model have largely been determined to be syntactically error-free. In that compiler theory and error processing are well known to those of average skill in the art, they will not be discussed here in further detail.

Path-Data Model Generation

The Path-Data Model Generation process is the critical operational process for FIOSM generation. The input to this process is:
a parsed system as defined in the previous section.
   The output is:
a model that represents all possible input-output data element patterns inherently defined in the parsed system.

The design of the language and demonstrating that it is FIOSM compliant is foundational. This makes it possible to use, for example, an Artificial Intelligence algorithm to create the model, or equivalently, the semantics, of any program written in the ioExample language.

As mentioned, although this embodiment is specific to the ioExample language, the algorithms and processes used herein are applicable to a large family of FIOSM compliant computer languages. The usage of the word “model” in this section is specific and equivalent to the definition of FIOSM found above:
A FIOSM is composed of a set of patterns of input data elements and output data elements, as defined above.
The model produced in this process will itself produce a set of patterns of ALL data elements, not just input and output. Thus, it should be clear that the generation of a model that defines the state of ALL data elements makes the generation of the FIOSM a matter of superficial reformatting.

This particular exemplary embodiment uses a tableau algorithm to search through the code paths inherent in the input system. The process at a high-level is:
translate the entry-point parse tree into the model logic representation,
“seed” the model generator with this translation, and
execute the tableau algorithm until it terminates.

After termination, the model generator will contain all possible data element patterns inherent in the execution of the input system

What follows is:
a definition of the representation used in this process,
definitions of the processes themselves.

Throughout the discussion of the processes, there are detailed examples, using the Interest Rate system, that illustrate the action of the processes.

Representation

The representation issues for model generation involve the task of defining:
the model logic
the model representation
the model container,
the model generator data areas.

These, by and large, are very straightforward and conform to the requirements of the tableau algorithm. The only other representation used in this section is the parse tree format discussed in the previous section. By far, the most elaborate representation is the model logic, which likely could benefit from introduction. The model is a statement about program states and data states. Nothing has been introduced yet that represents these concepts. The model logic is one such representation. The model logic represents the states of program execution and associated data-but it does more than that. The model logic also represents logical constructs that correspond to program operators in programming languages, and is consistent with the requirements of the tableau algorithm used to generate the model.

Thus, the model logic is the central representation of this process stage. It not only is the representation used in the result, but also is an intermediate representation that eases the translation of programs into a tableau algorithm compliant format.

Model Logic

The model is composed of instances, elemental expressions, complex expressions, and terms.

### Instances

Instances represent concrete invocations of procedures, and of variables. There are, consequently three types:
ProcedureInstance
NumericInstance
CodeInstances

Each unique instance has a unique name. The model container has the responsibility for the generation and naming of instances.

Elemental Expressions

Elemental expressions in the model logic represent a final result in the model logic. Collectively, they represent a program execution graph. This is illustrated in this subsection below: “Tableau, Model, Graphs.” There are three types of elemental expressions:

(NumericFeature <featureName> <numericInstance>)
(CodeFeature <featureName> <codeInstance>)
(ProcedureFeature <procedureInstanceName> <ProcedureInstance>)

Each type of expression is identified first: NumericFeature, CodeFeature, ProcedureLink). Following the type, the specific name of the feature is declared, respectively: <featureName>, <featureName>, and <procedurelnstanceName>. These names are typically generated in the rules processing by the model container. The final entry in these expressions is the instance that is pointed to, respectively: <numericlnstance>, <codelnstance>, and <Procedurelnstance>.

Complex Expressions

Complex Expressions are expressions for which there are rules in the tableau processing. They are intermediate results, and the language to which the parsed source is translated.
There are the following complex expressions in the model logic:
(CodeConstraint <CodeExpression>): is used to model a code constraint expression, typically in a conditional statement or assignments. CodeConstraint is the type identifier, and
<CodeExpression> is an ioExample Code Comparison Expression as defined above in the ioExample language definition.
(NumericConstraint <NumericExpression>): is used to model a numeric expression, typically in a conditional statement or assignments. NumericConstraint is the type identifier, and
<NumericExpression> is an ioExample Numeric Comparison Expression as defined above in the ioExample language definition.
(ReturnCodeConstraint <CodeExpression>): is used to model a “return value” from a procedure.
ReturnCodeConstraint is the type identifier, and <CodeExpression> is an ioExample Code Comparison Expression as defined above in the ioExample language definition.
(ReturnNumericConstraint <NumericComparisonExpression>): is used to model a “return value” from a procedure. ReturnNumericConstraint is the type identifier, and
<NumericComparisonExpression> is an ioExample Numeric Comparison Expression as defined above in the ioExample language definition.
(ProcedureLink <ProcedureName> <ProcedureExpression>): is used to model a procedure call.
ProcedureLink is the type of the expression. <ProcedureExpression> is the model logic expression representing the procedure being called.
(And <modelExpression1> . . . <modelExpressionN>): is used to compose compound statements in model logic. This is used to model the sequential execution of program operators. “And” is the type of the expression, <modelExpression1> . . . <modelExpressionN> represents a list of arbitrary size of model logic statements.
(Or <modelExpression1>, <modelExpression2>): is used to model conditional “either-or” statements.
“Or” is the type identifier, and the two <modelExpression#> are expressions in model logic.

Terms

A term is an assertional unit in model logic. It combines both the expressions and the instances. Terms in model logic take the form:
<Expression>(<ProcedureInstance>)
   The <Expression> can be any expression in model logic, complex or elemental. The <Procedurelnstance> is a procedure instance as defined above.

Translation

Model logic is created from the parsed system, and is the first stage of model generation, as described below. The only distinctive data representation used in the translation process is the “symbol table.” The Symbol-Table is used to track variable states and procedure instances during the creation of model logic from parsed systems. This is discussed and illustrated at length in the sections below. It contains:
Variable-Entries: an entry for each variable, and will contain a variable-name, and an associated integer counter initialized to zero.
Procedure-Entries: an entry for each procedure invoked in the system, and will contain a procedure name and an associated integer counter initialized to zero.

Model Generator Related Representation

The process of generating the model requires a variety of representations to hold and control the tableau process. Principal among these is a representation called, appropriately, a model generator. What follows below is a definition of that representation, and the unique representations contained therein.

The Model Generator is the highest-level representation associated with the tableau process. It contains:
Input-Queue: a queue of Model Containers waiting to be processed by the generator.
Valid-Models: a list of the valid models determined by the algorithm.

The Model Container is the representation that corresponds to a single pattern model, that is, the model of a single unique pattern of execution of the system. It contains the structure needed by the tableau to build and validate the path-data pattern. When finished, it contains the pattern. It contains:
Term-Queue: a queue where terms are stored in anticipation of applying their corresponding rules
Abstract-Model-Container: a set of expressions expressing the execution and data structure of the model.
Numeric-Container: a container used to validate the Numeric data flow.
Code-Container: a container used to validate the Code data flow.
Code-Integer-Association-Array: an array used to create one-to-one correspondence between Code value and integers.
Numeric-Instance-Counter: an integer used to generate unique instances.
Code-Instance-Counter: an integer used to generate unique instances.
Procedure-Instance-Counter: an integer used to generate unique instances.

Processes

### Translation

Translation in the context of Model generation takes the parsed system for input, and generates a model logic representation as output. The model logic output abstractly represents all possible code paths and data operations. The model logic is a representation that is used by the tableau algorithm to generate the complete set of pattern models in the next section. It is the responsibility of Translation to use the parse tree representation of the system to create structures that can be interpreted by the automated reasoning tableau algorithm to create the FIOSM model. There are particular issues that one must attend to in translation. Two in particular are the relationship between data elements and program variables, and the creation of procedure call instances. These two issues are discussed in the commentary section below.

Translation Processes

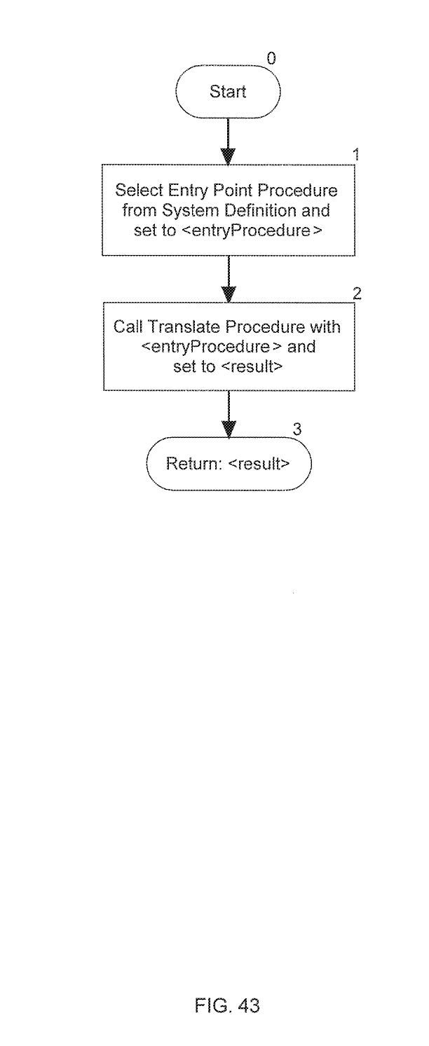

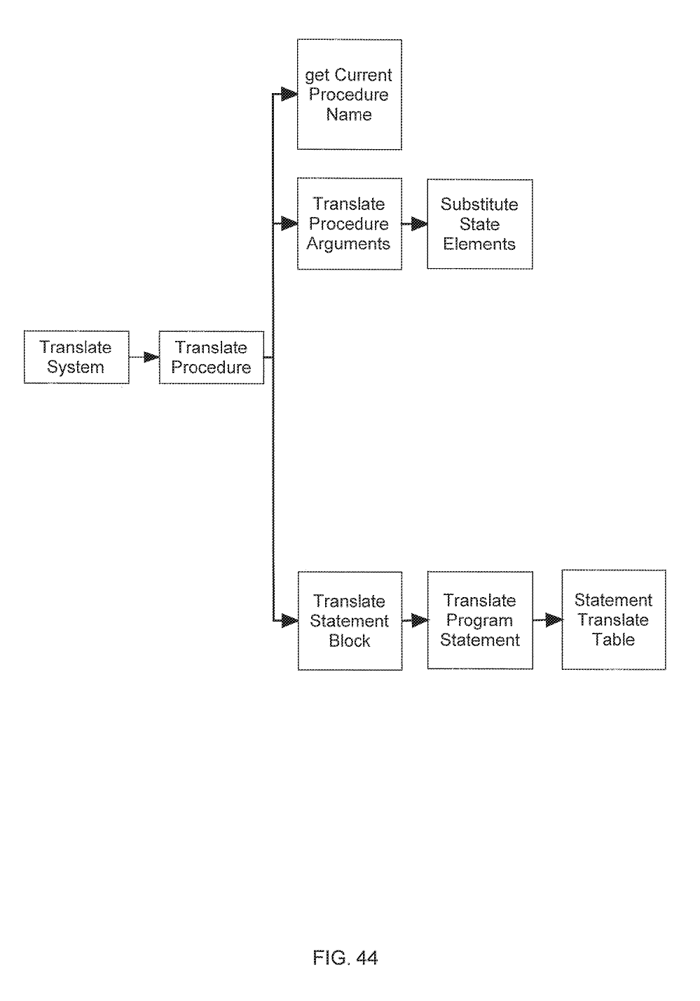

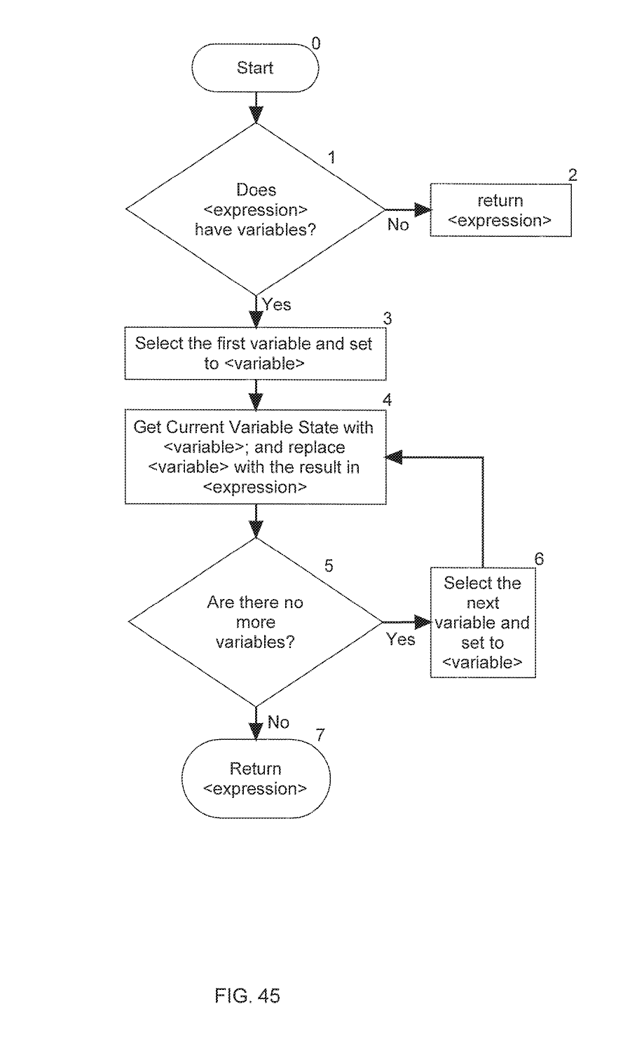

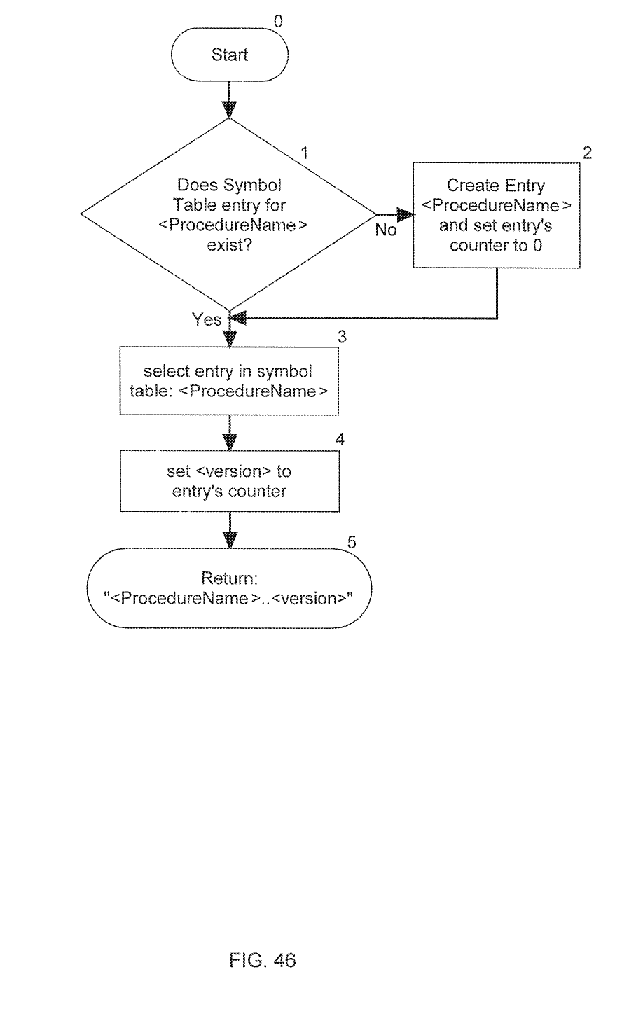

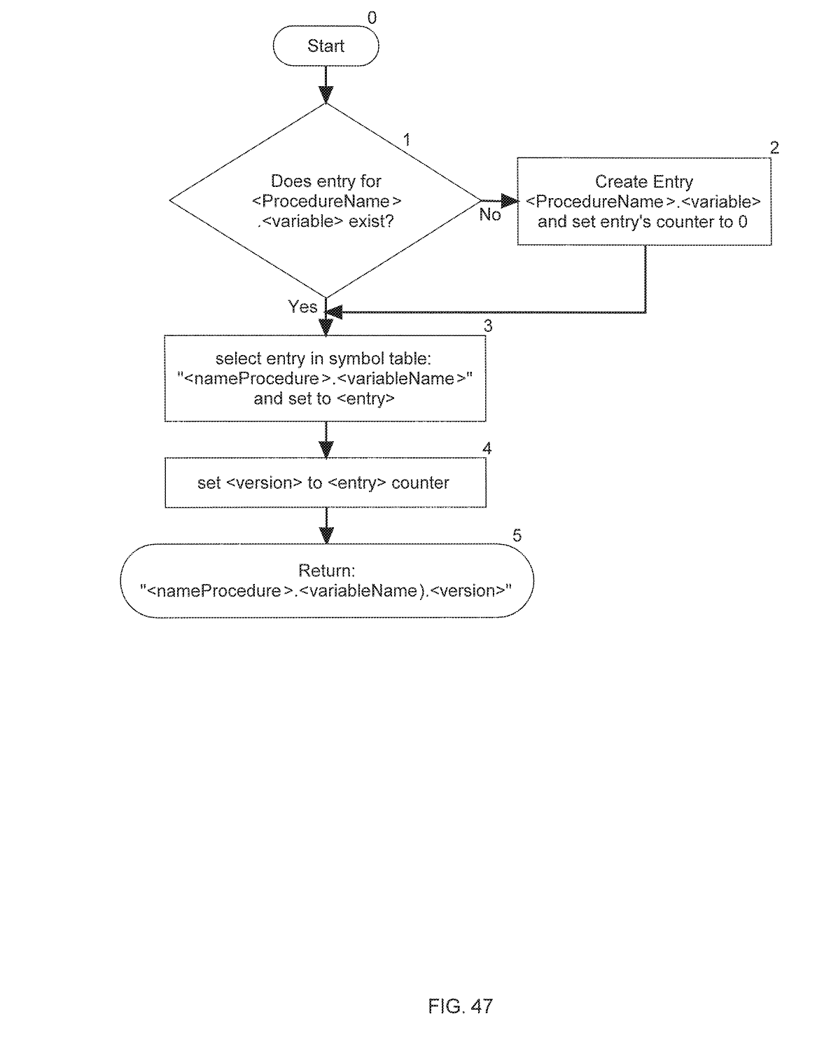

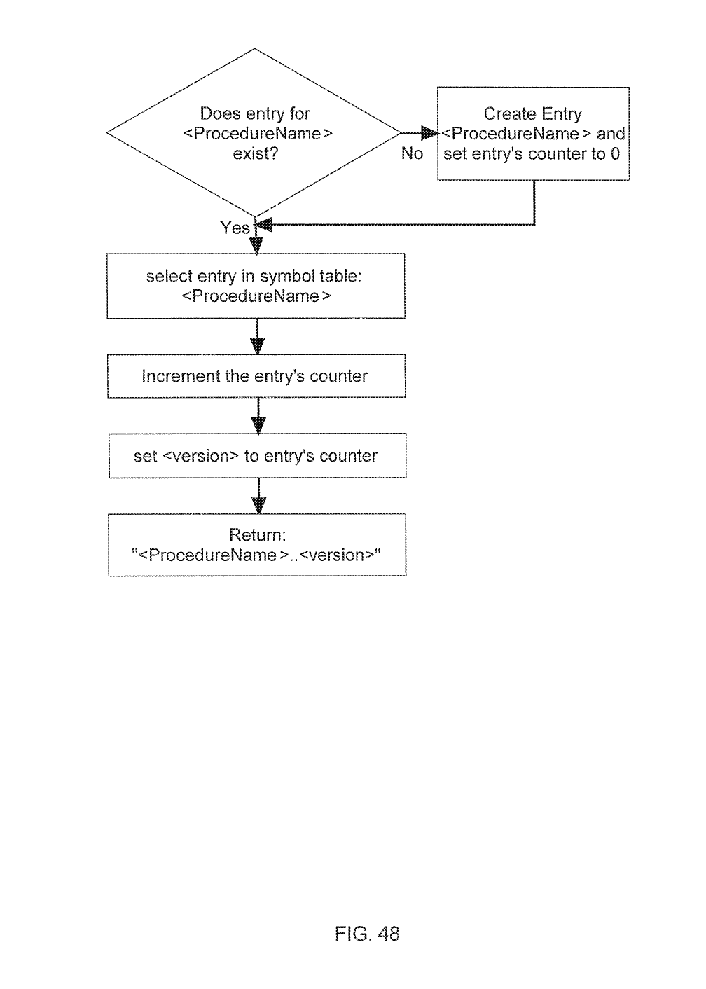

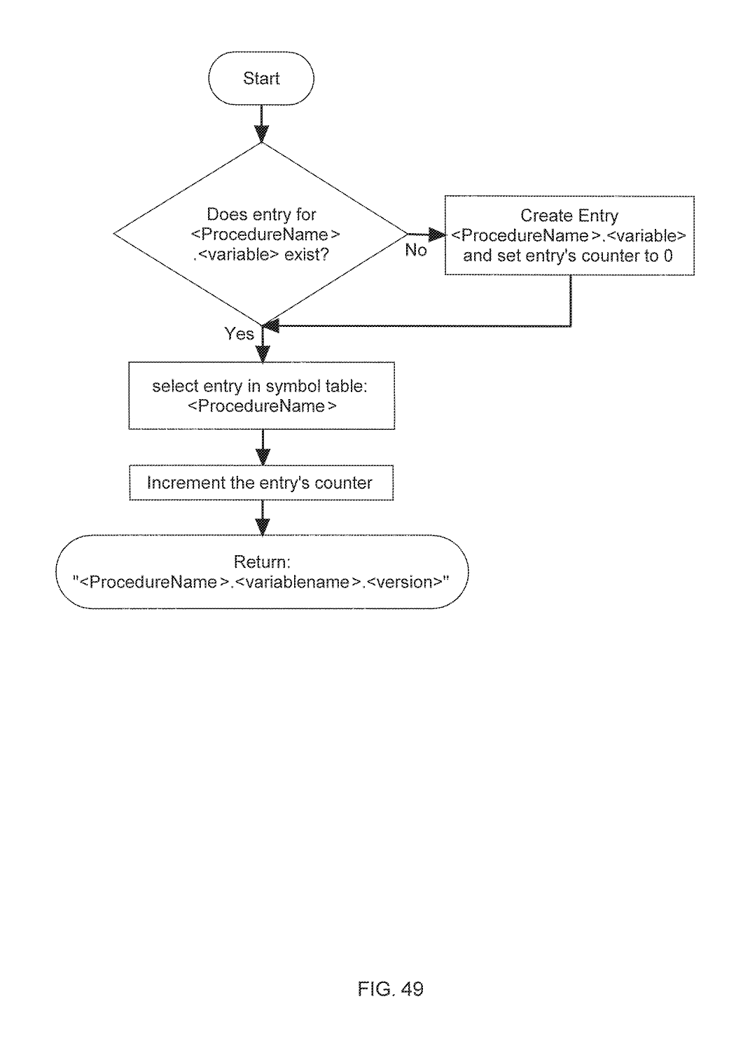

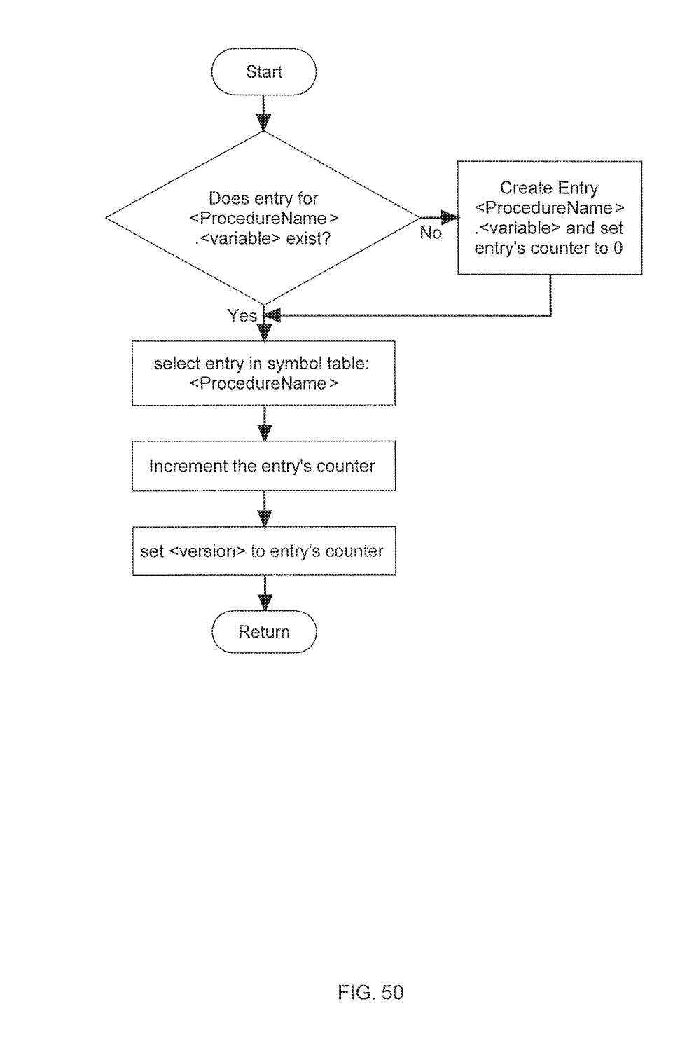

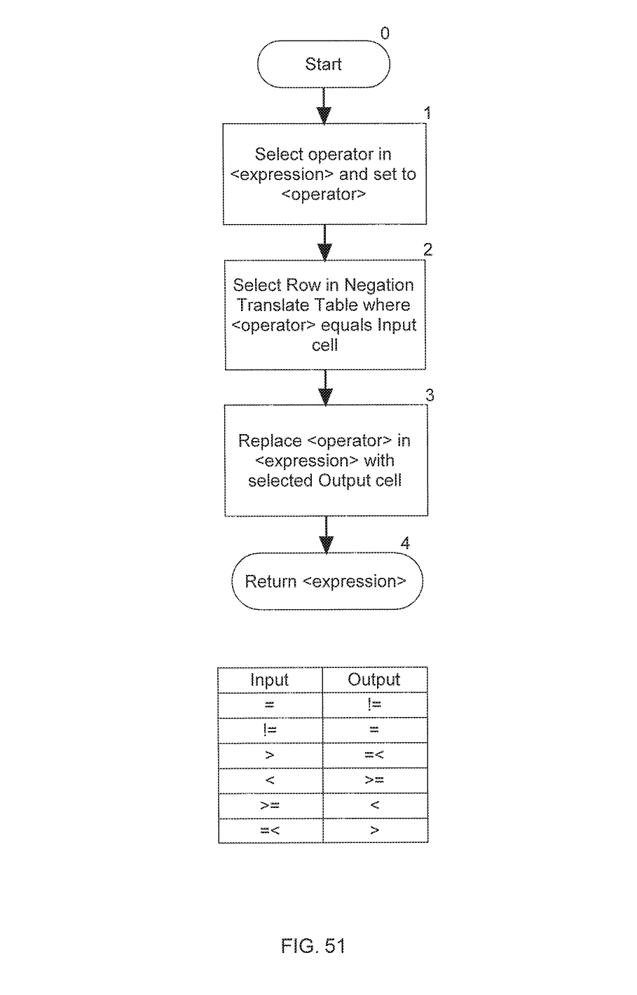

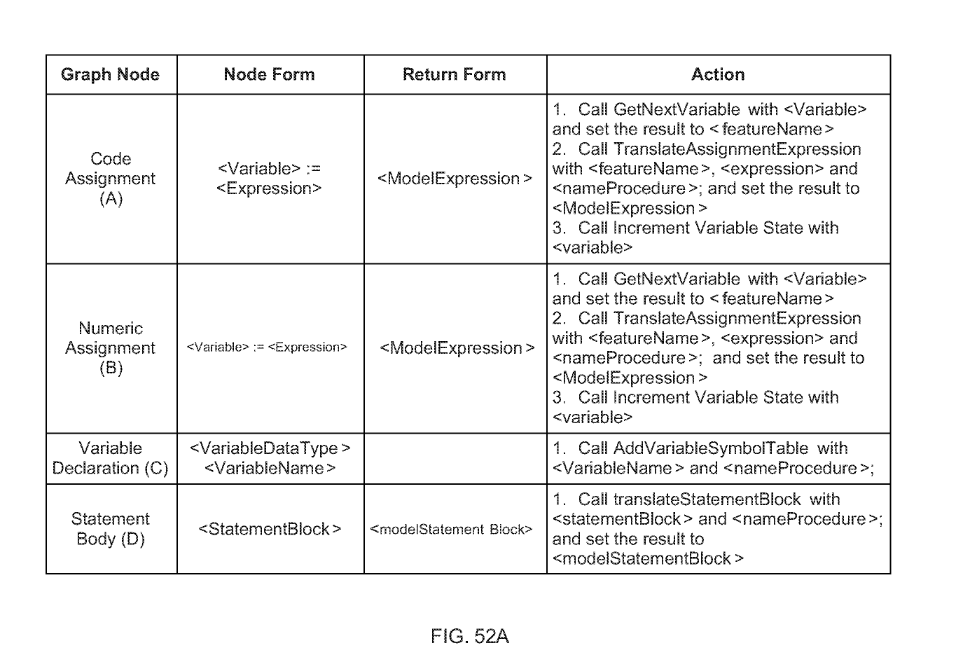

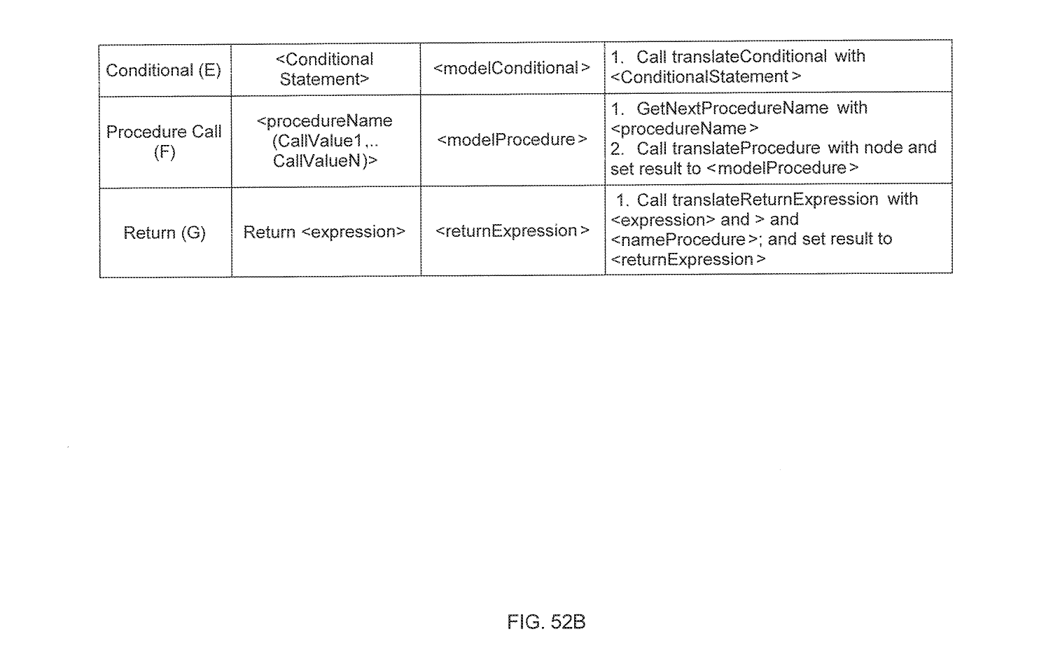

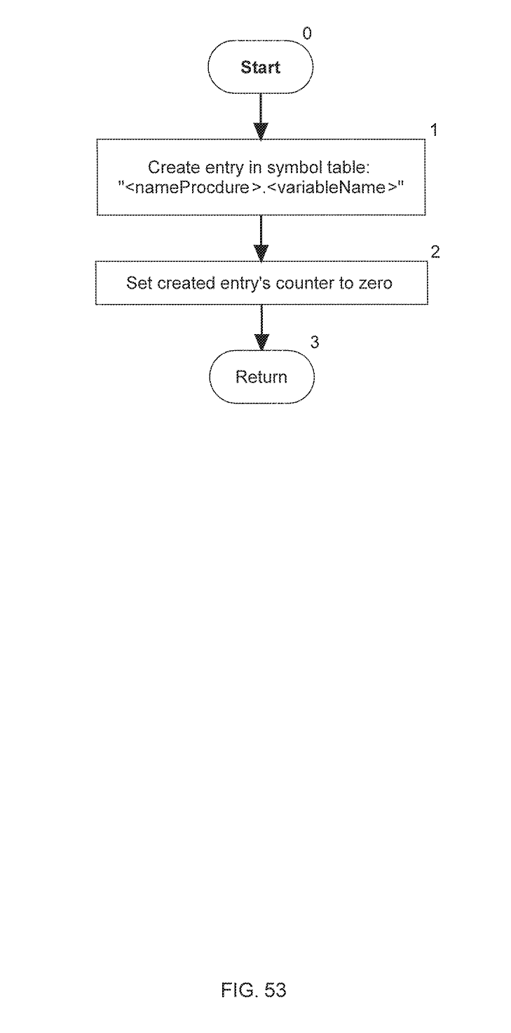

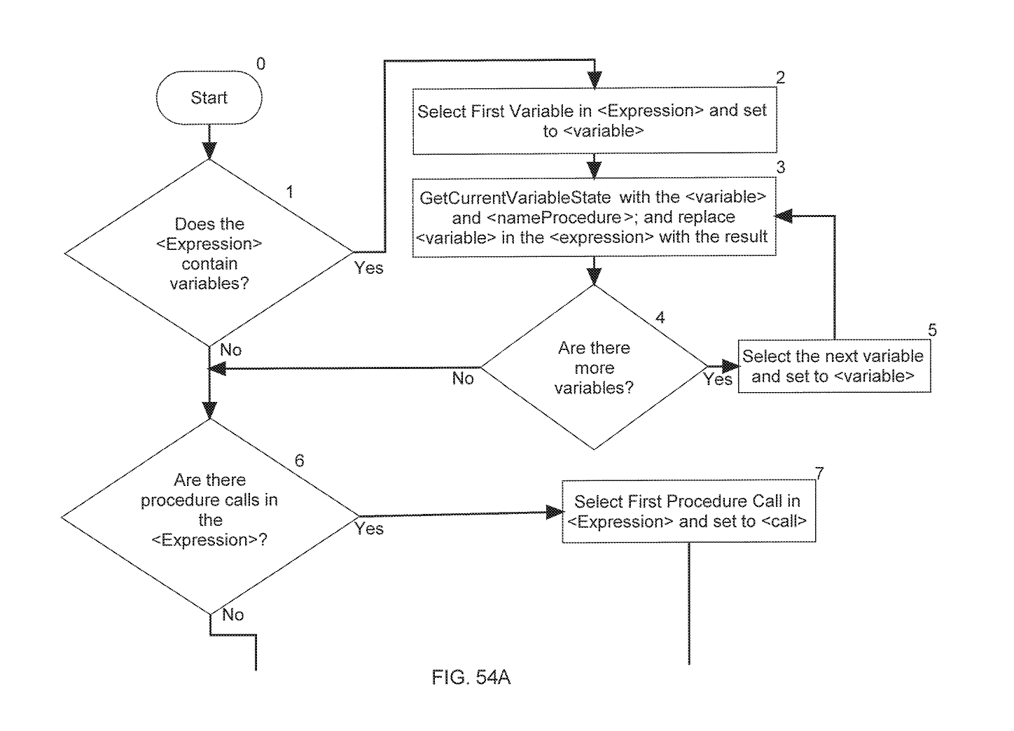

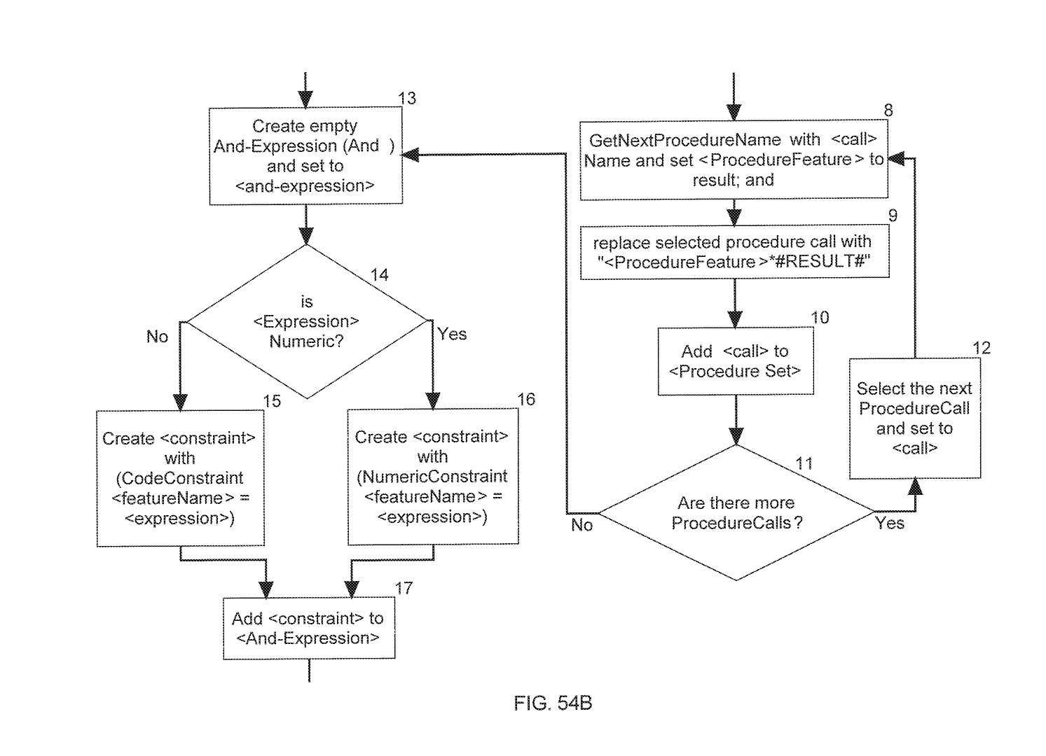

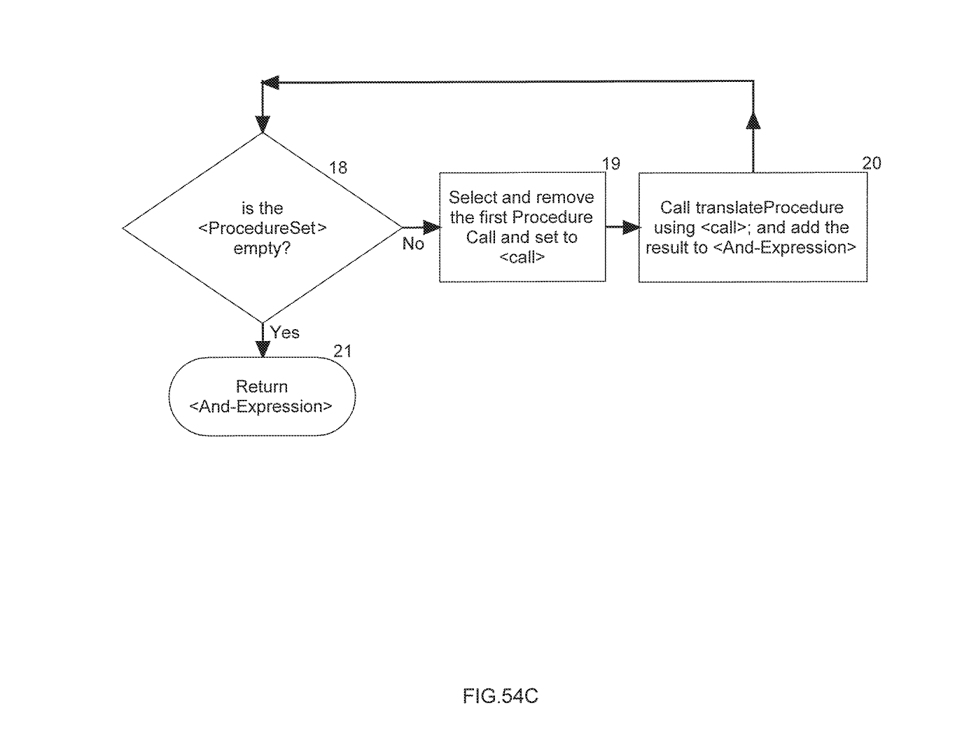

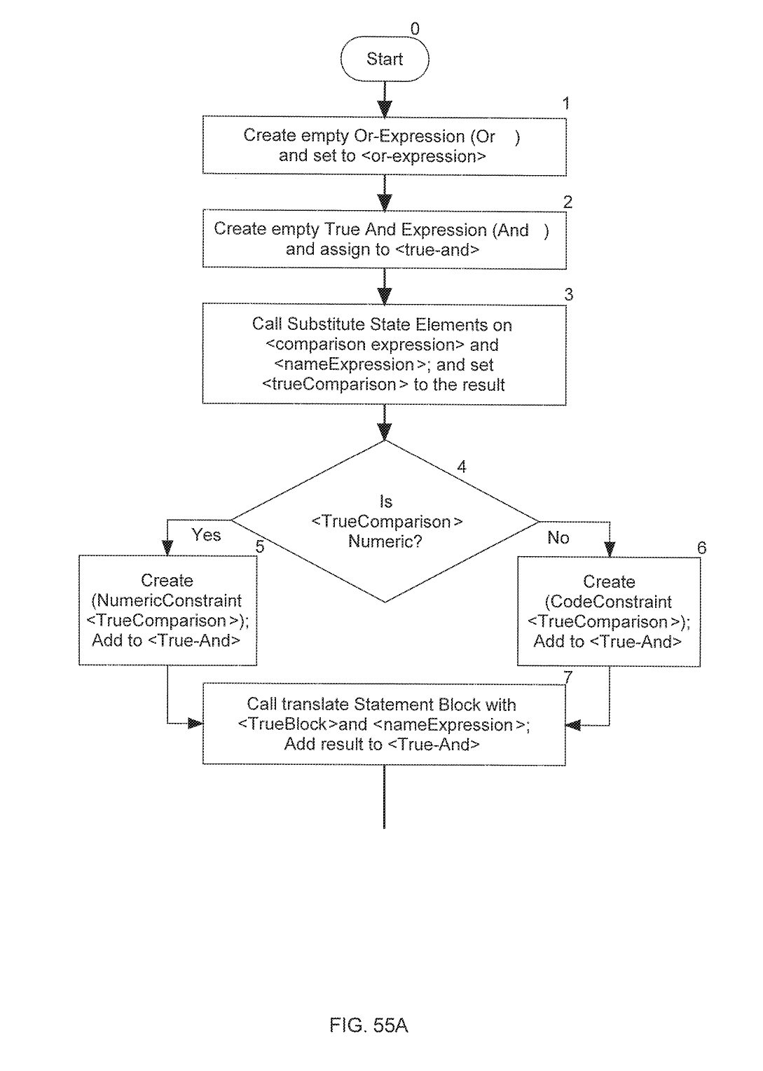

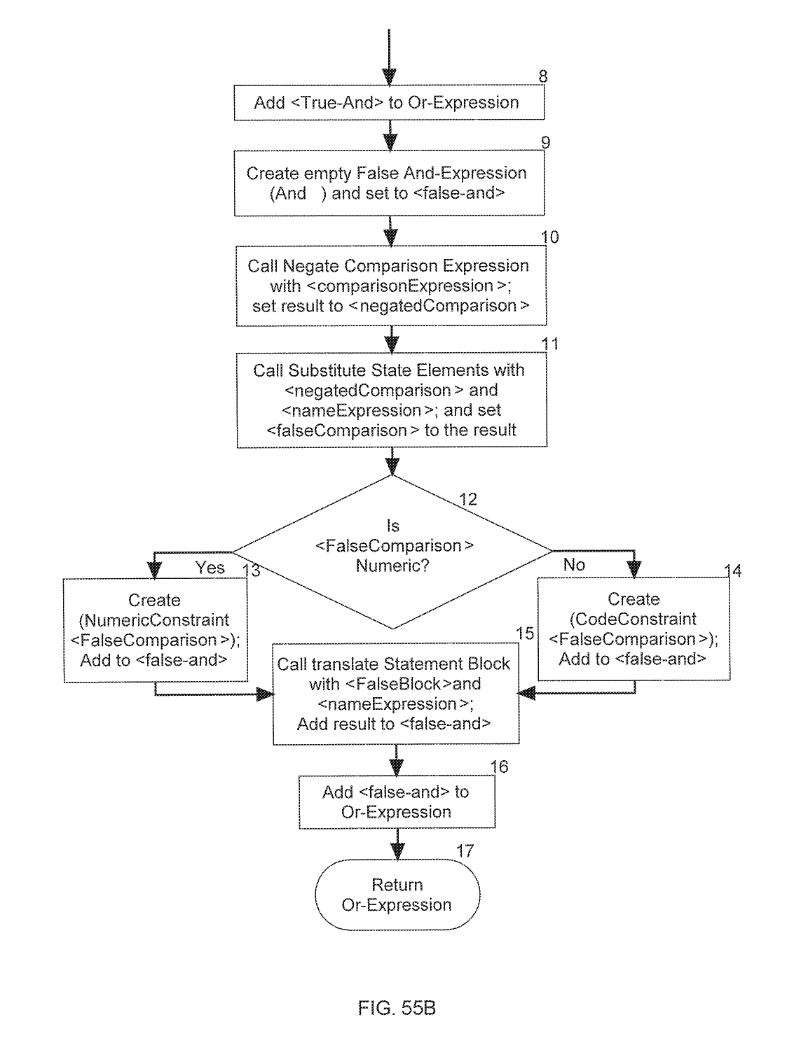

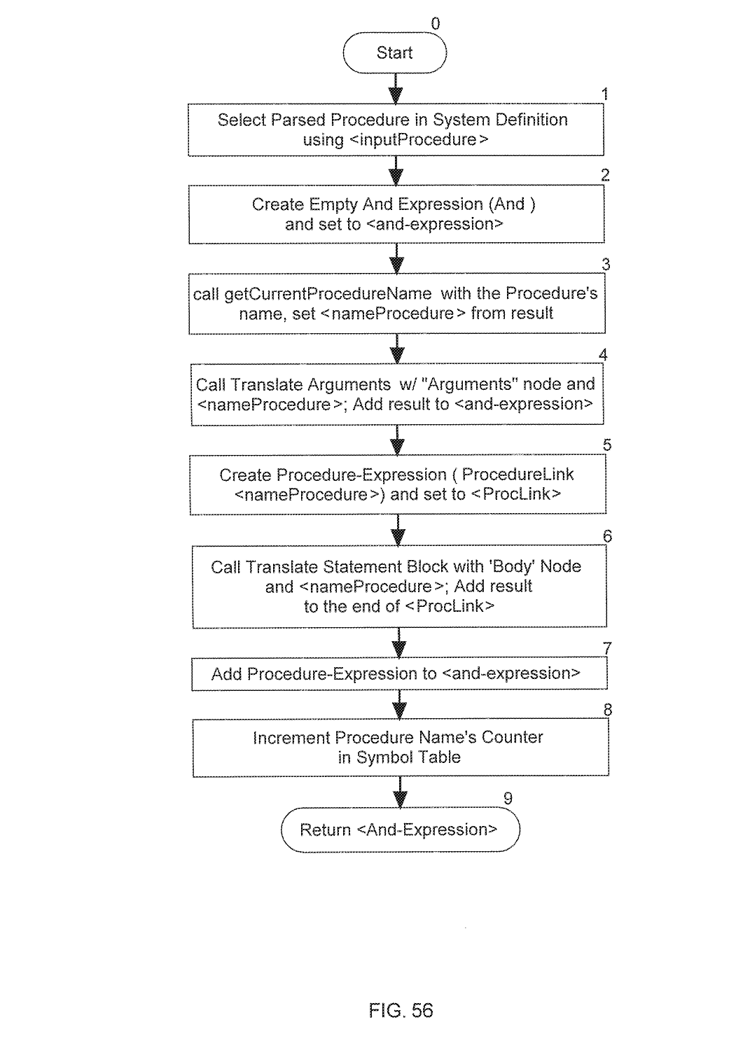

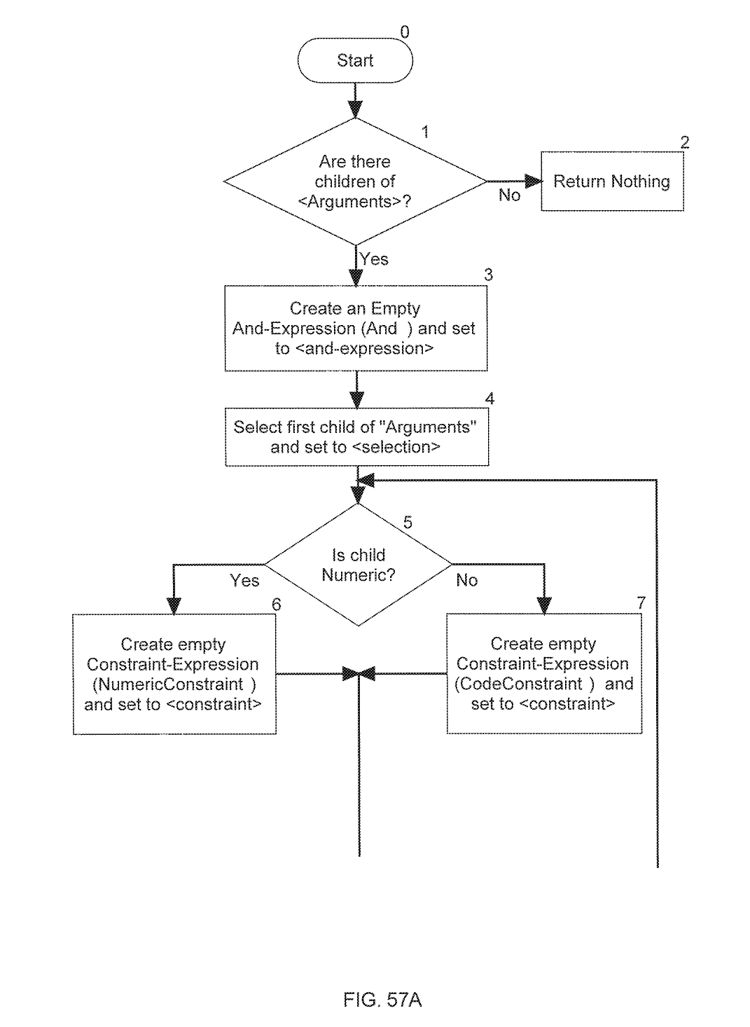

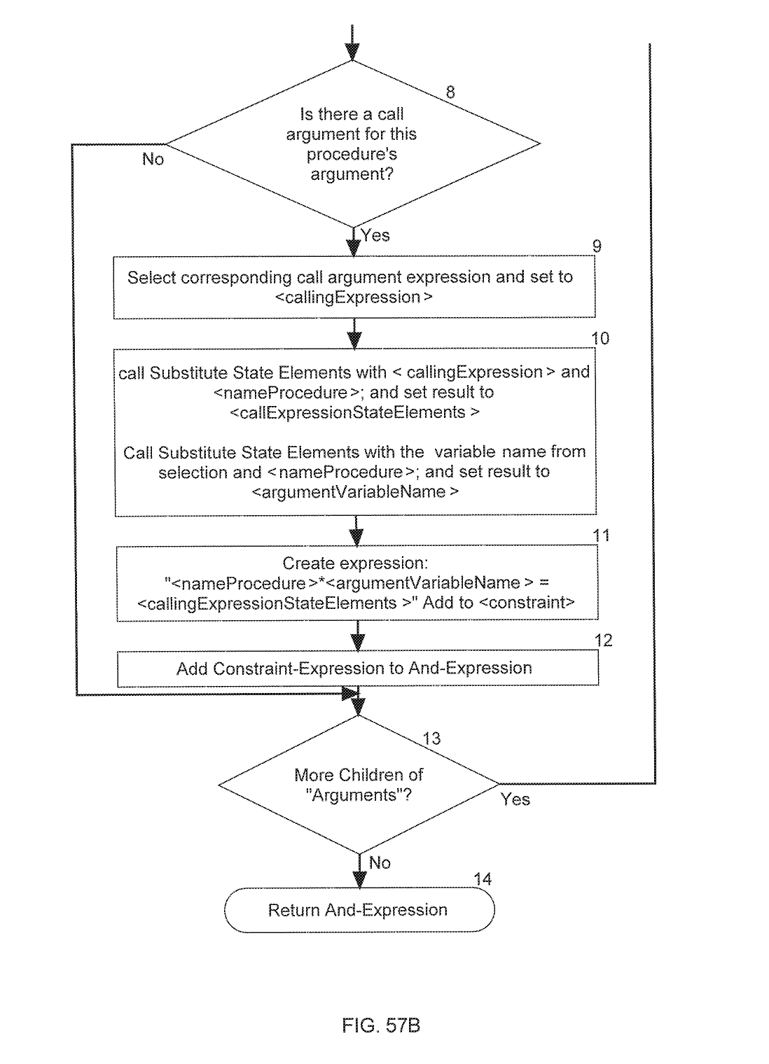

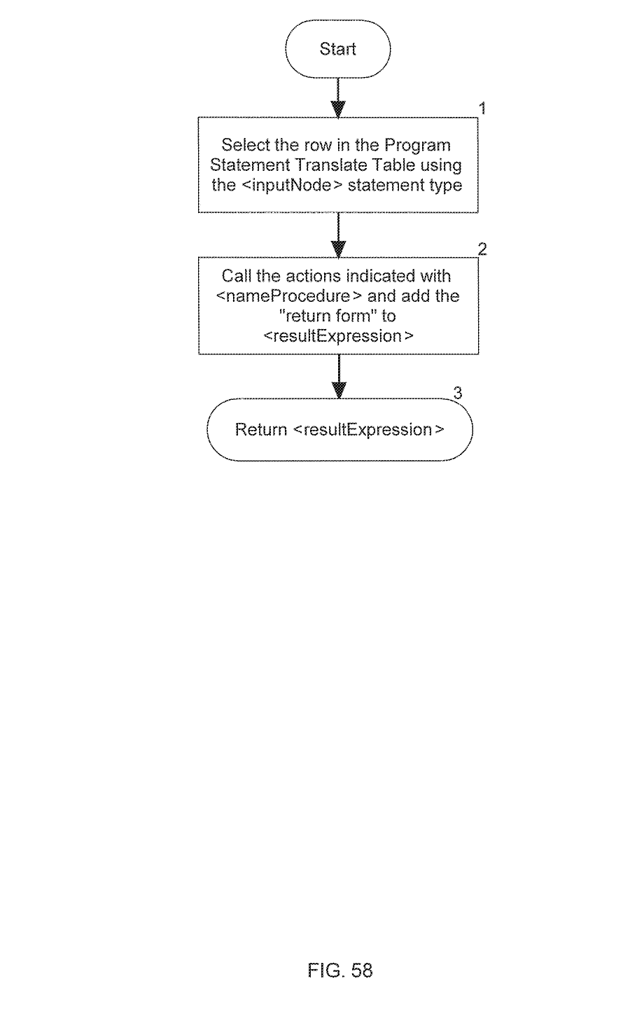

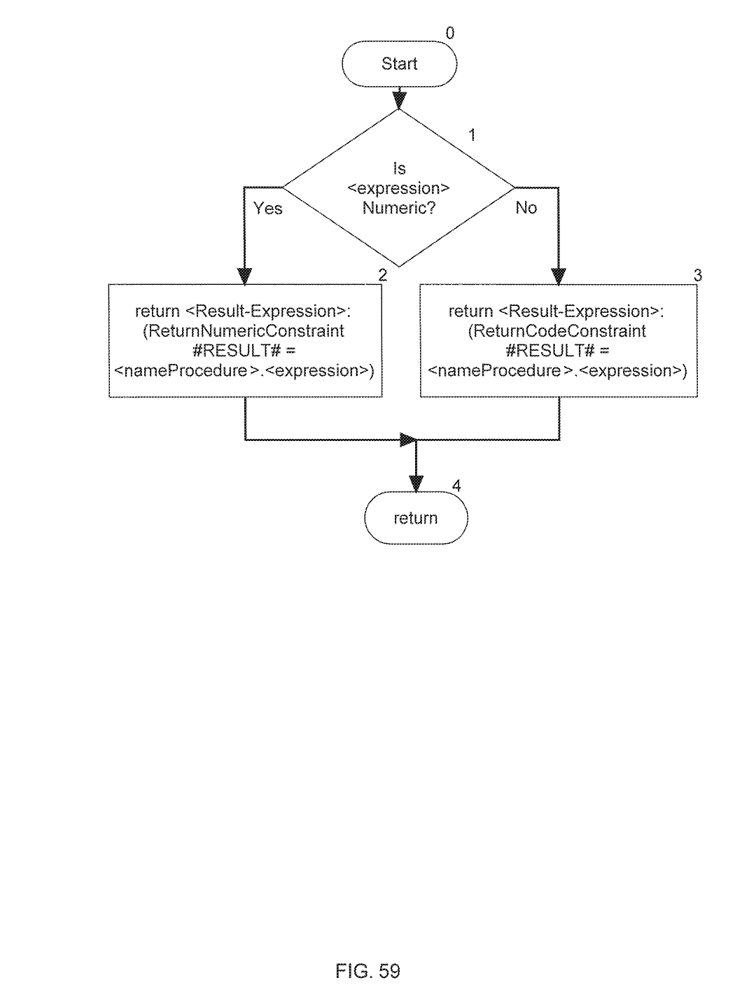

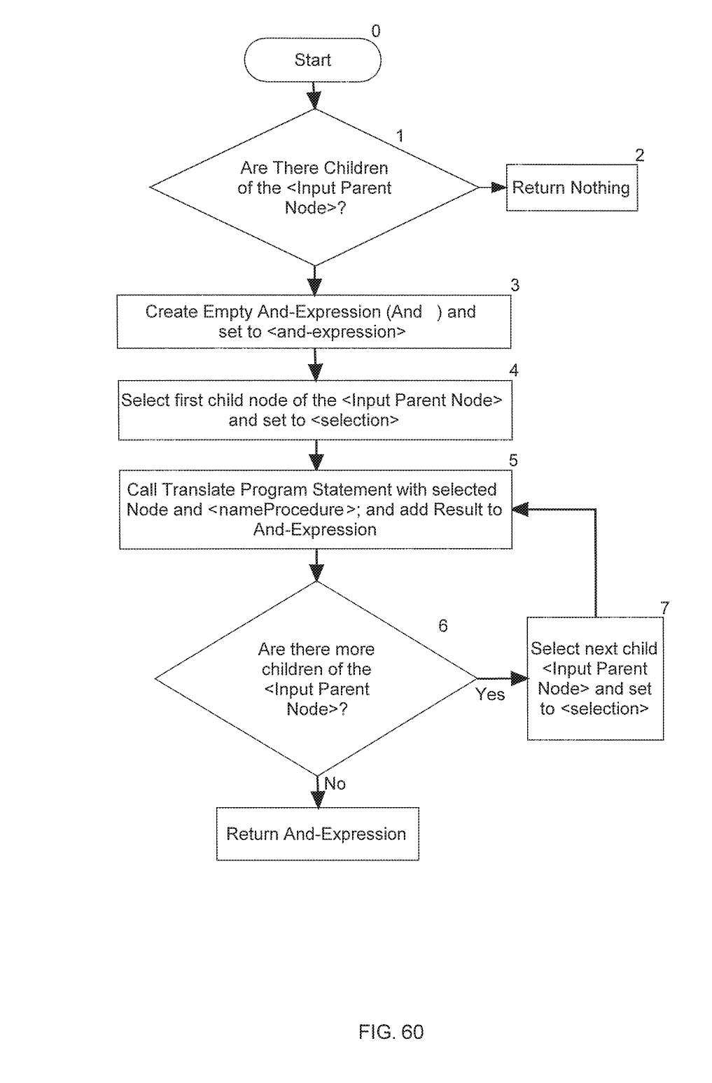

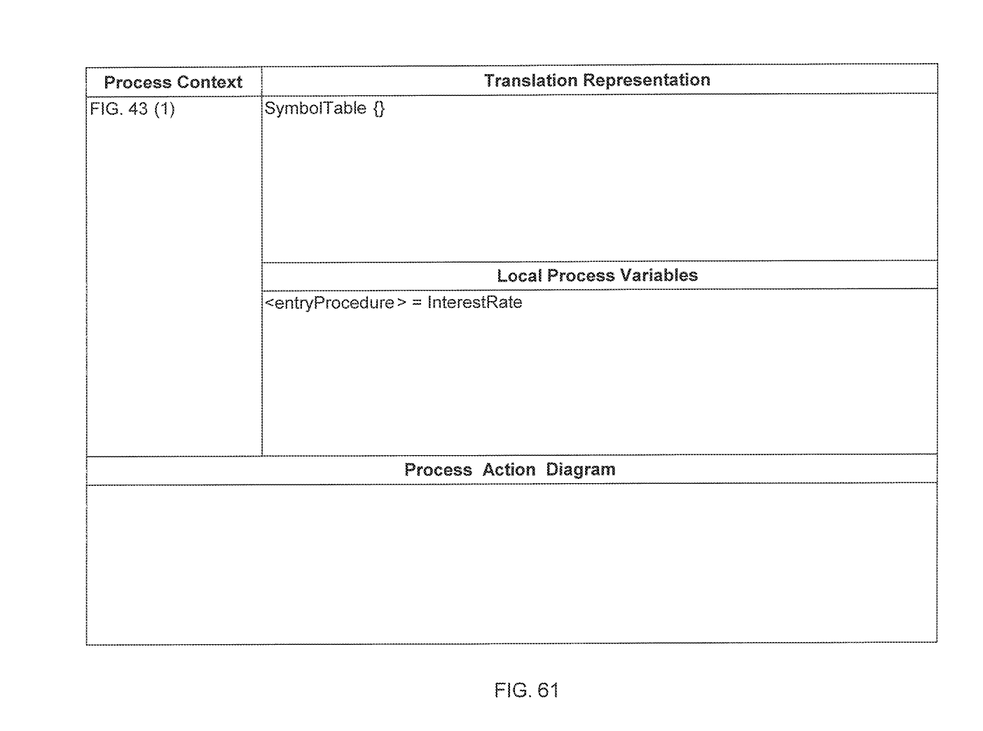

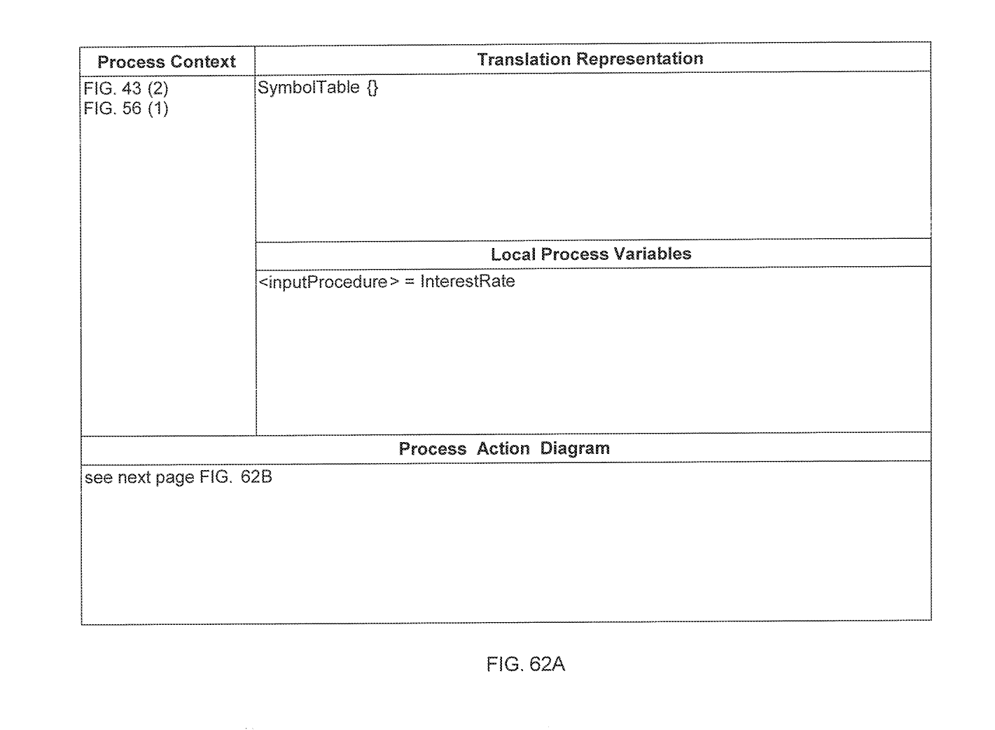

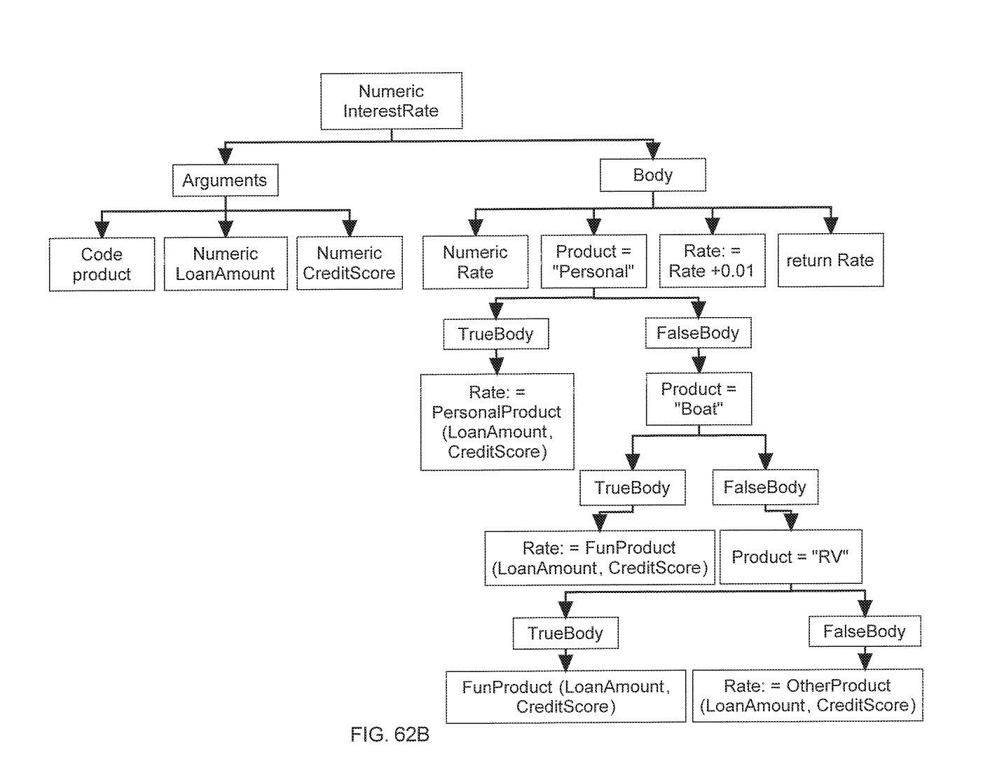

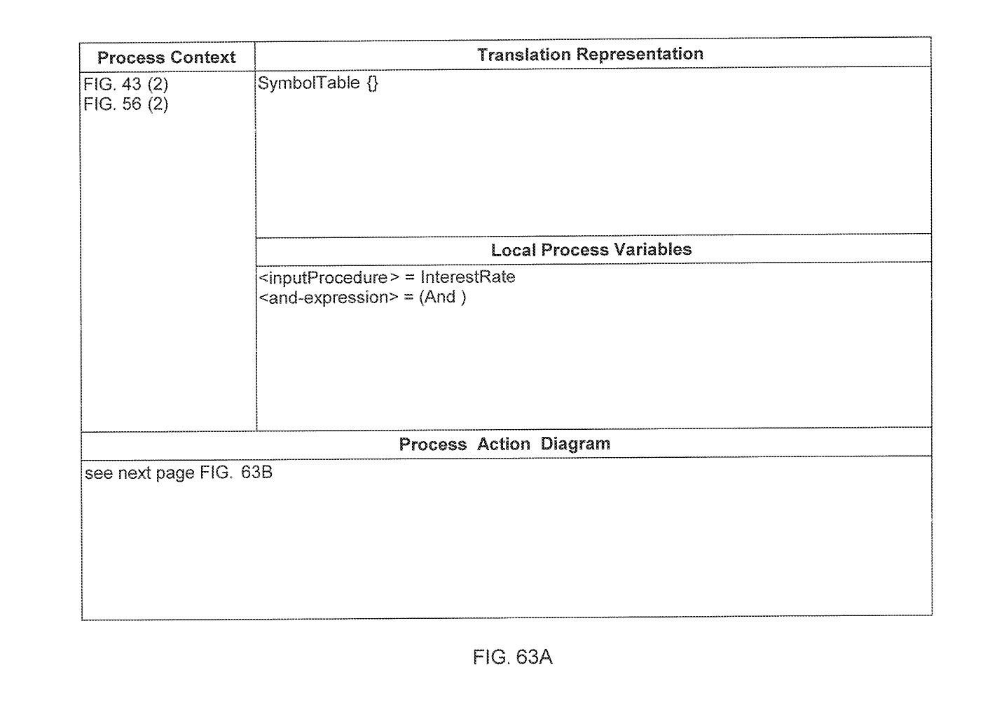

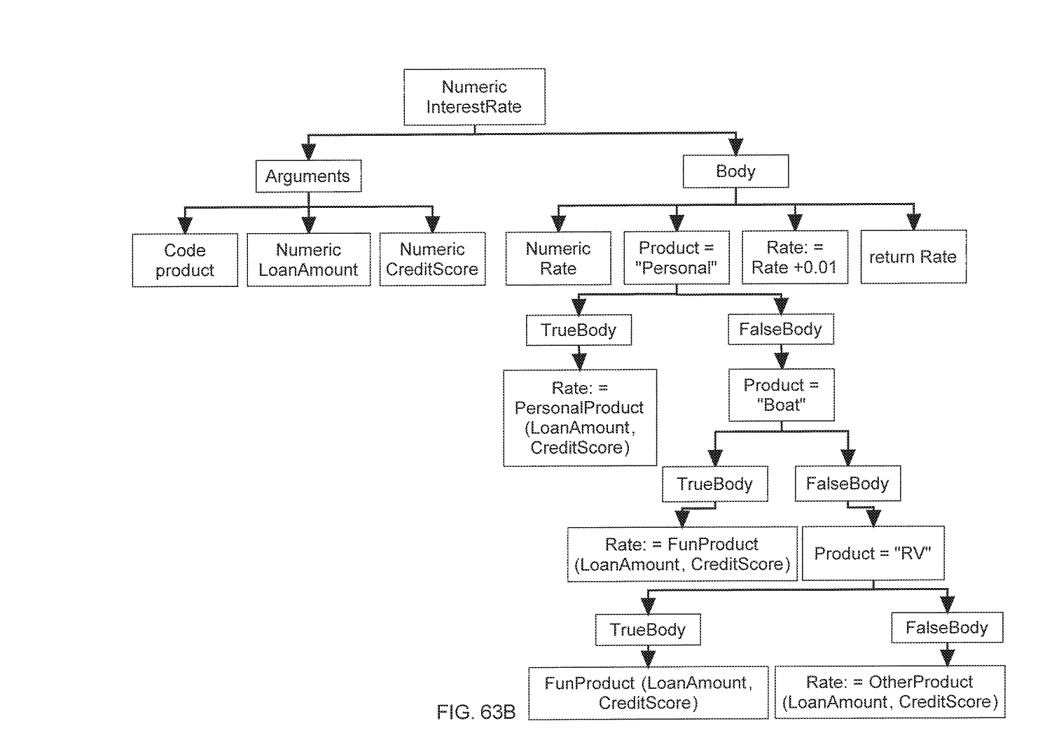

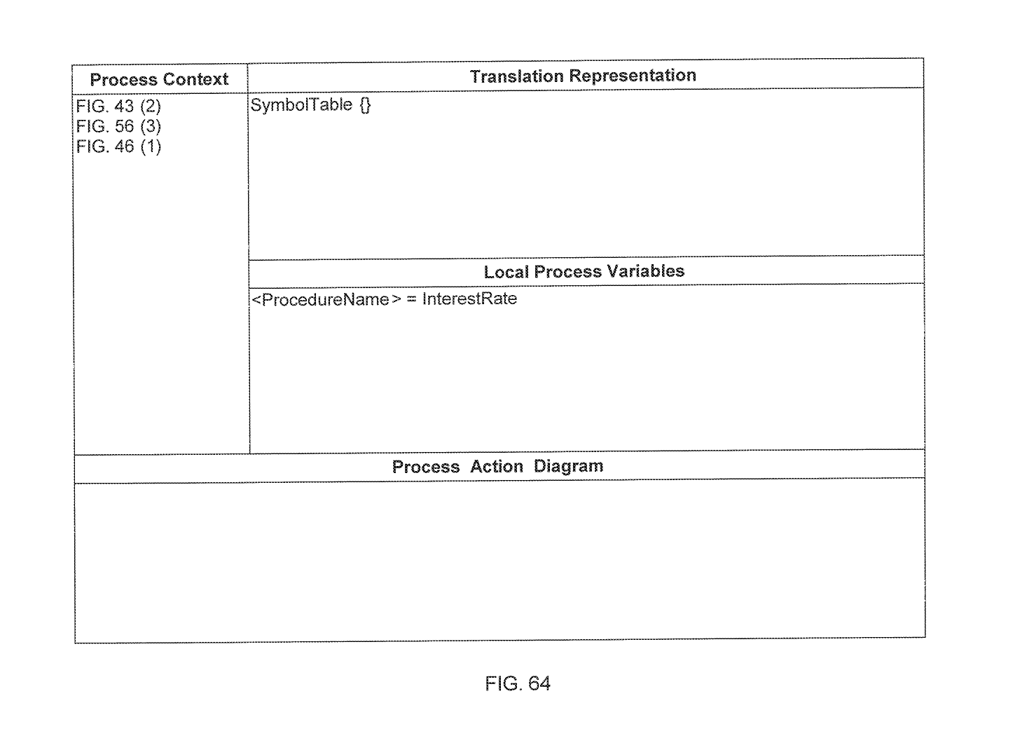

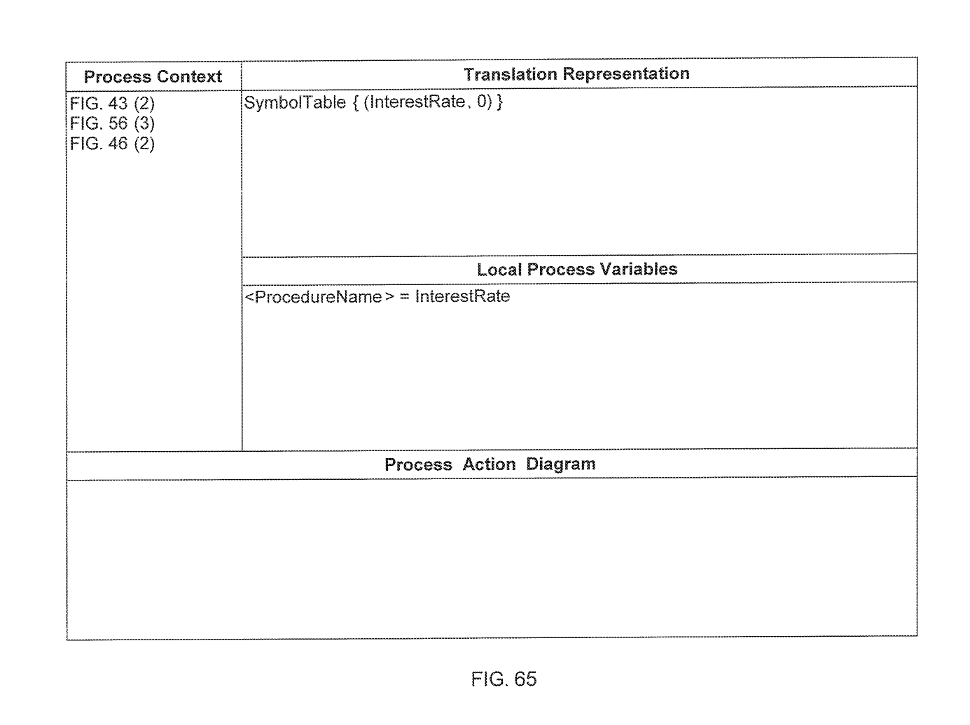

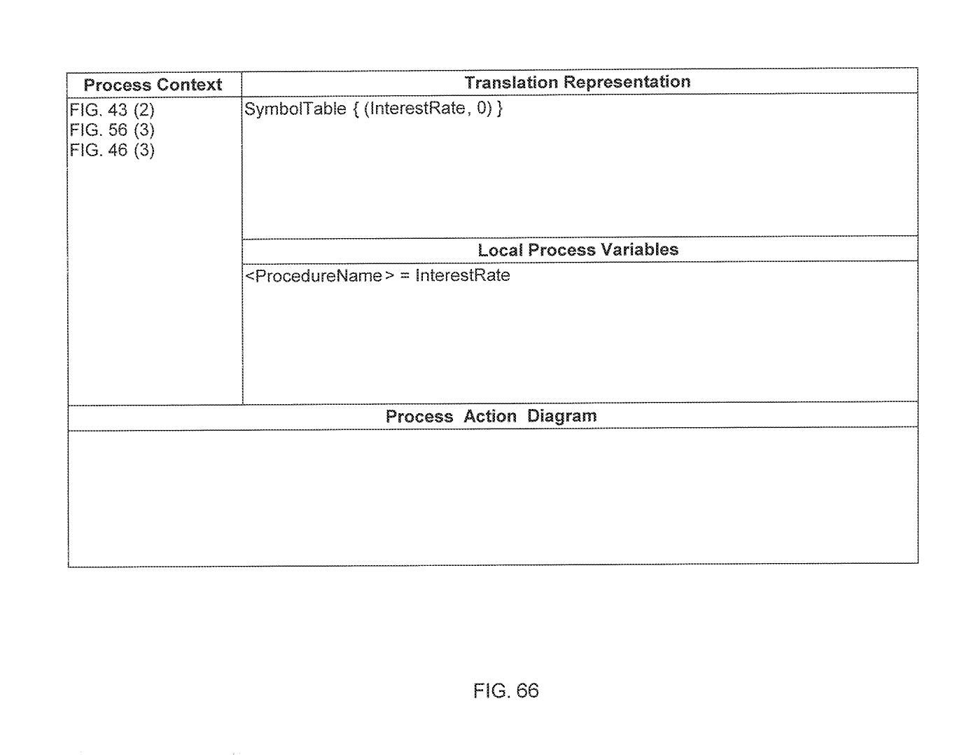

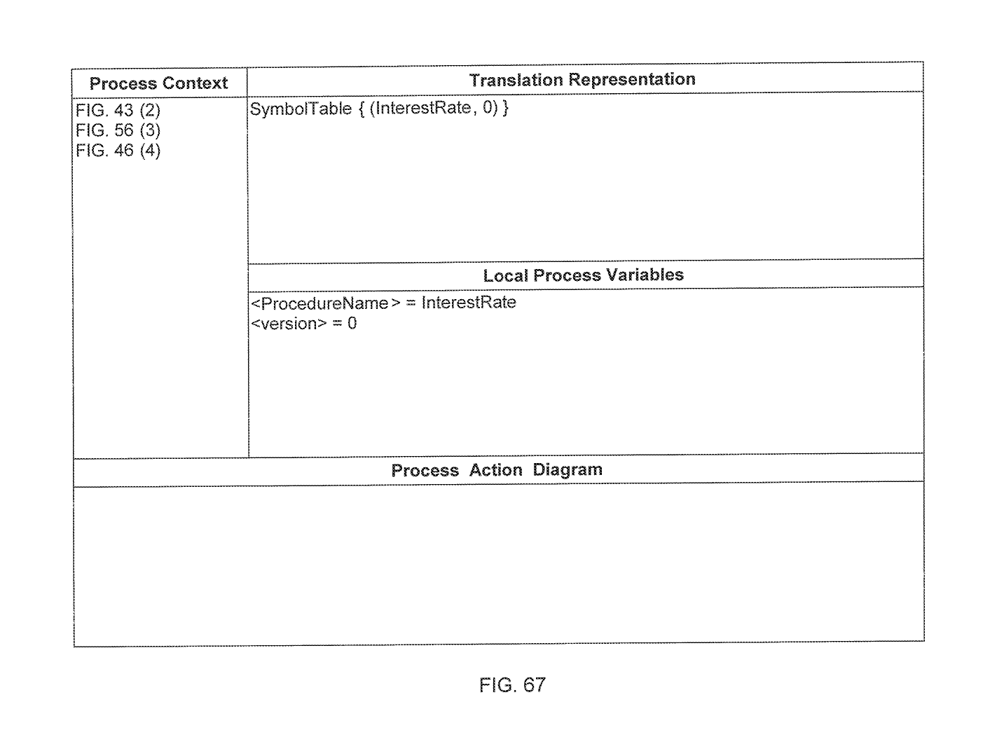

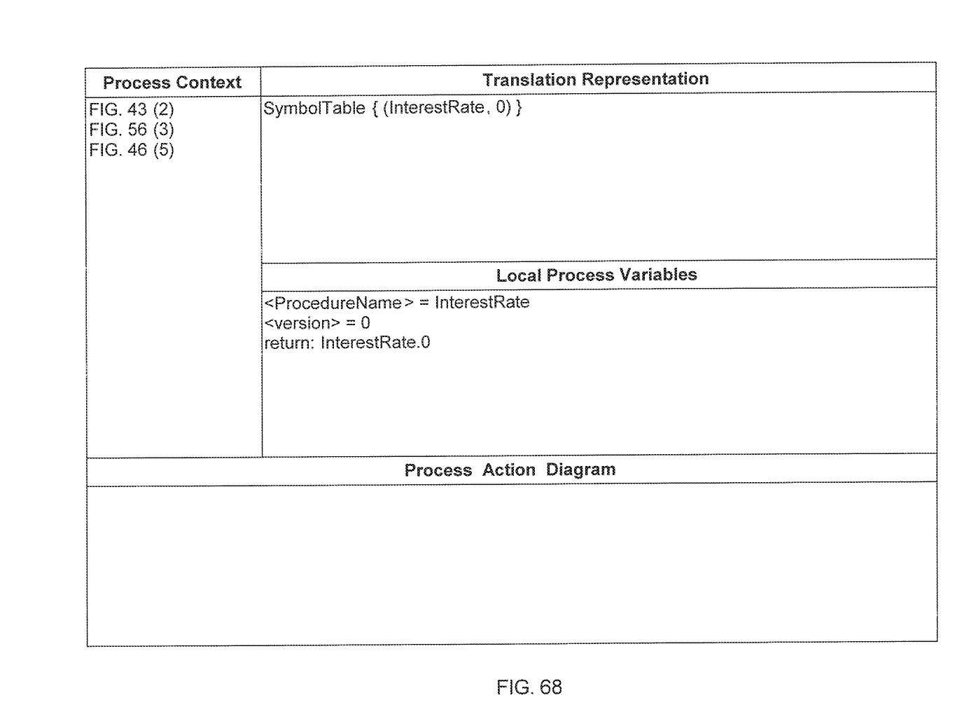

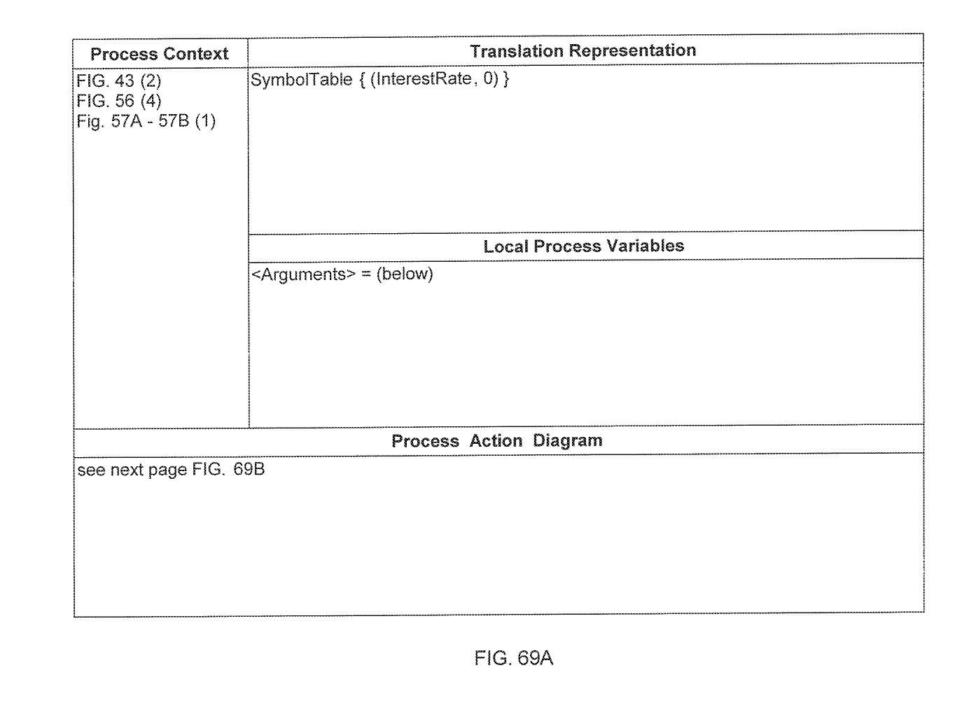

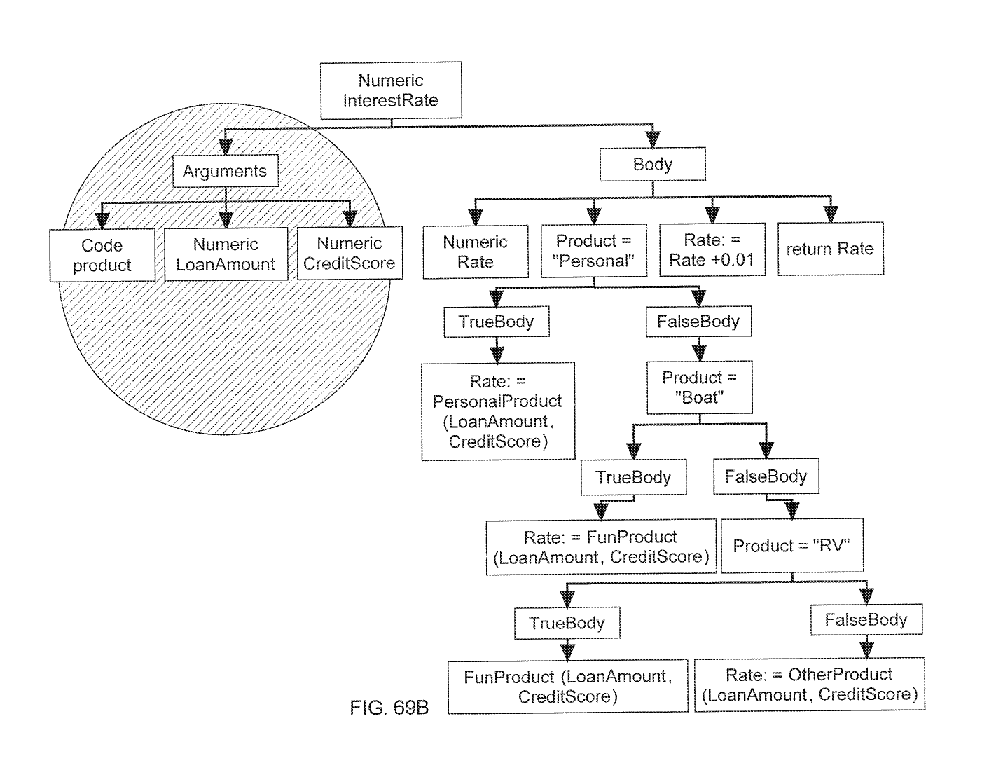

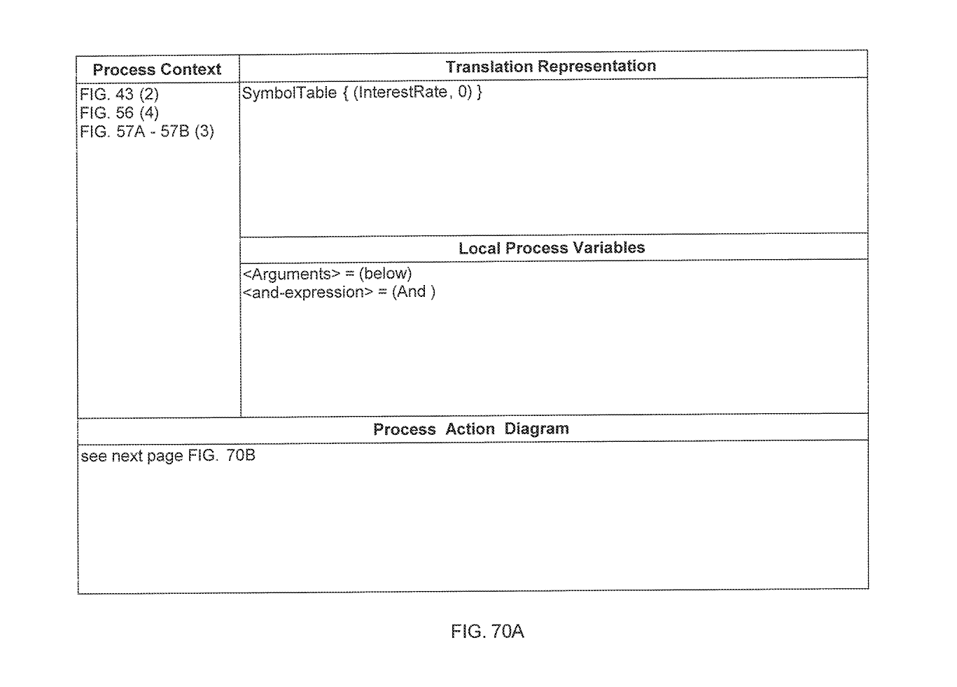

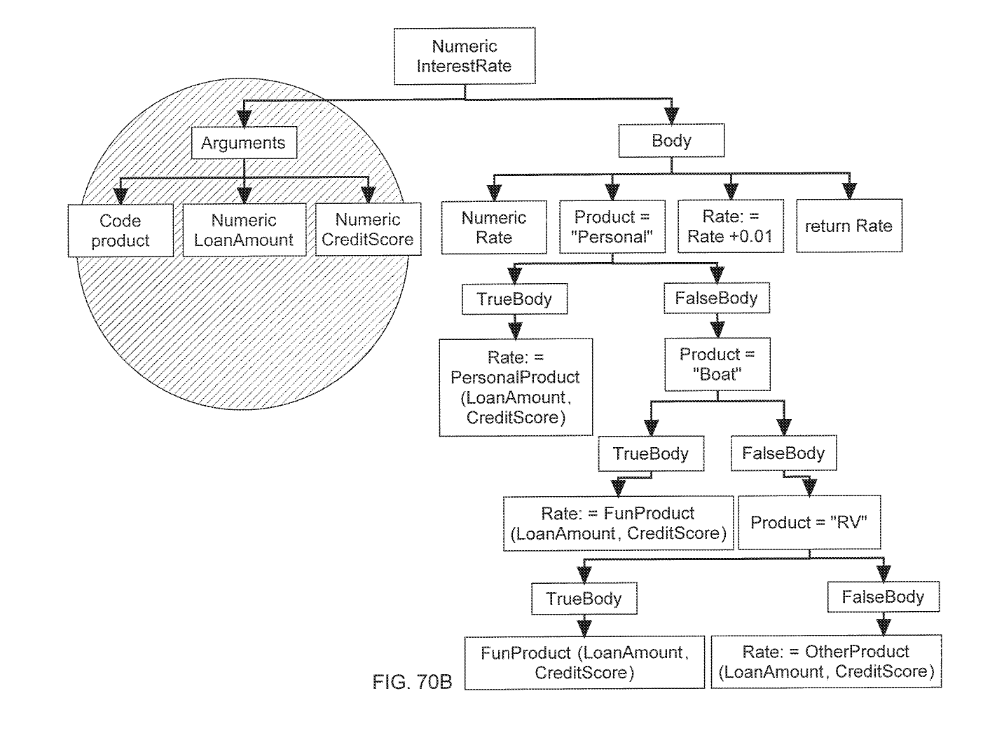

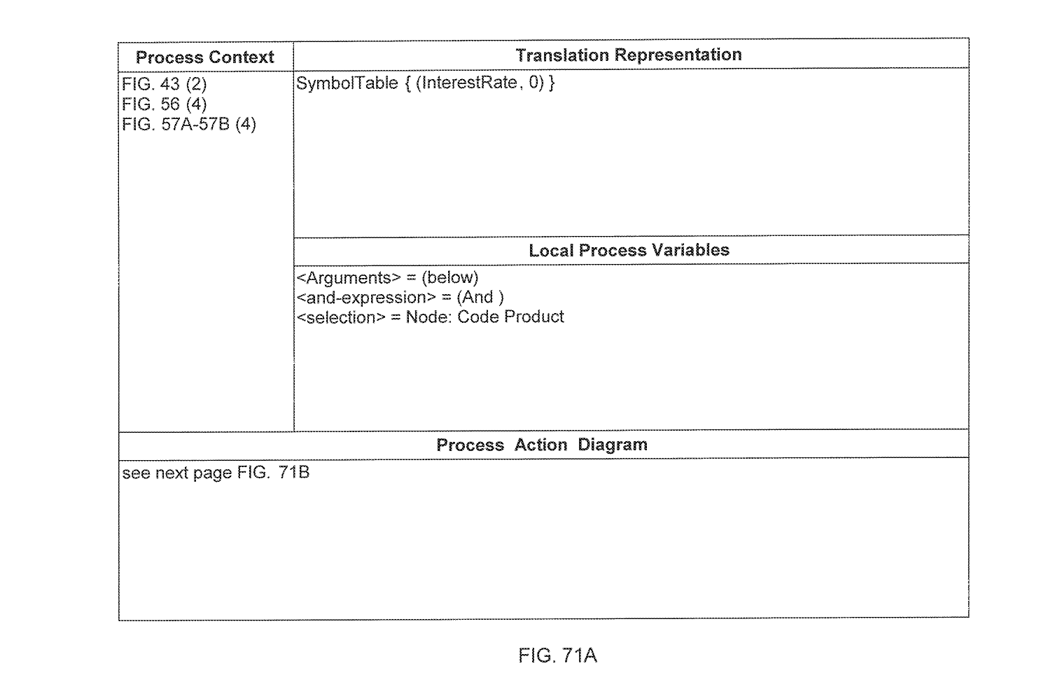

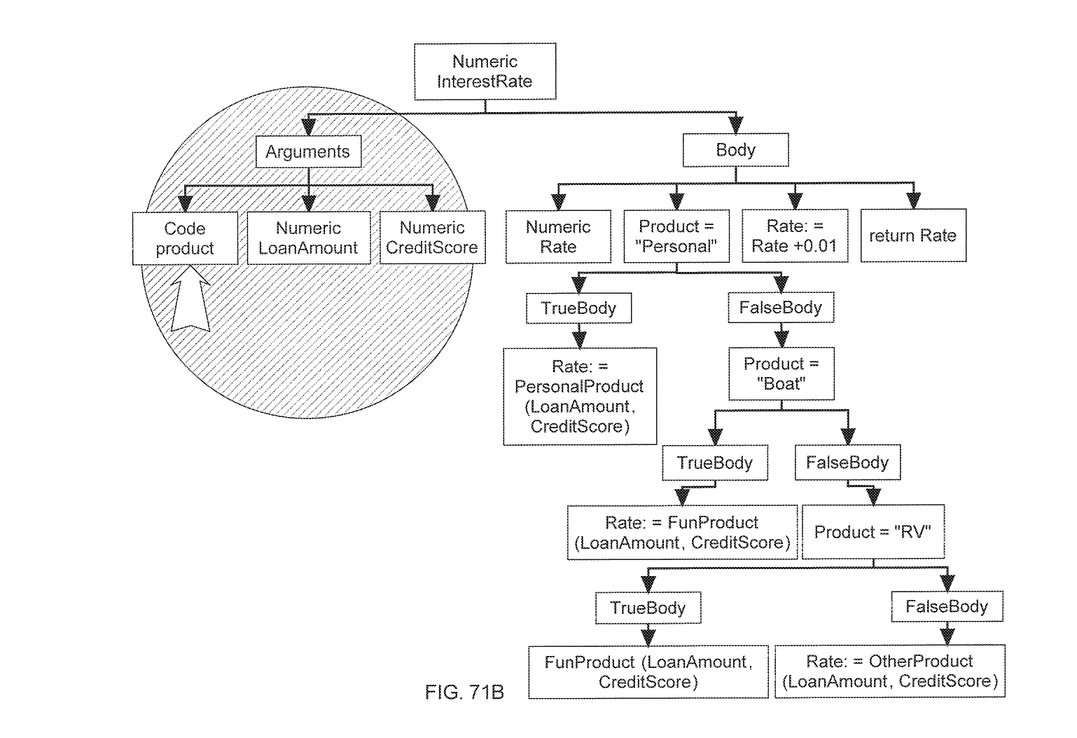

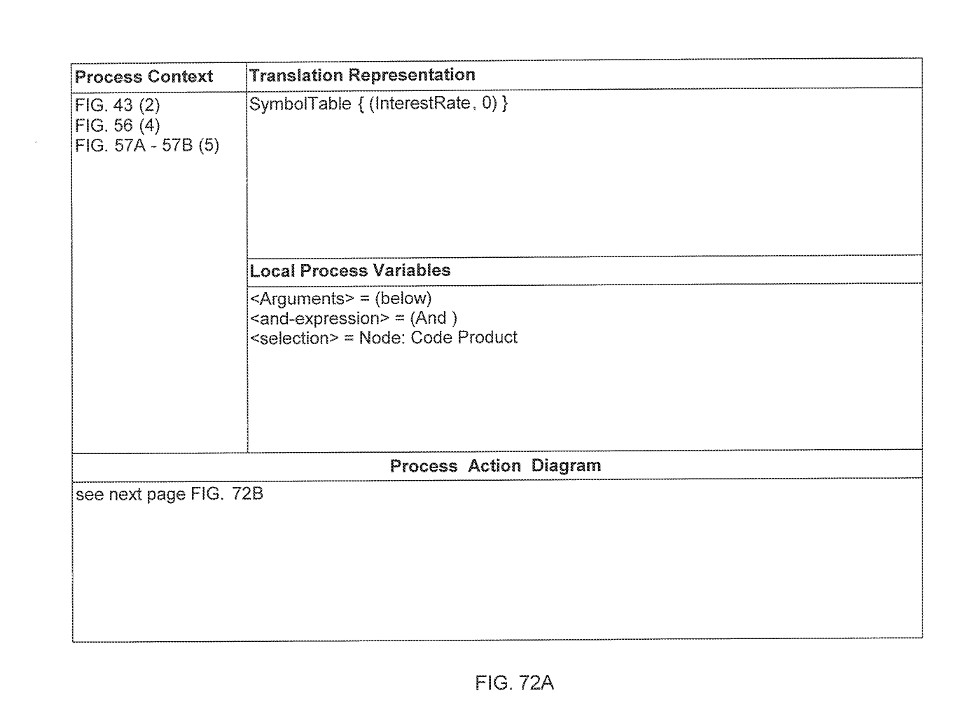

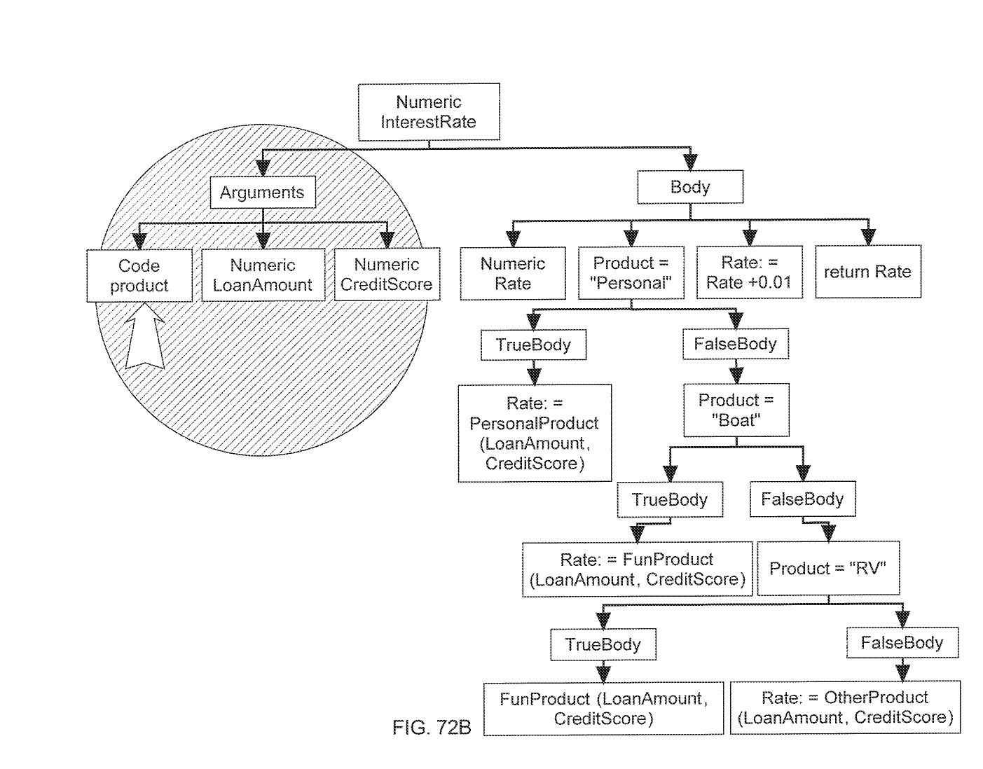

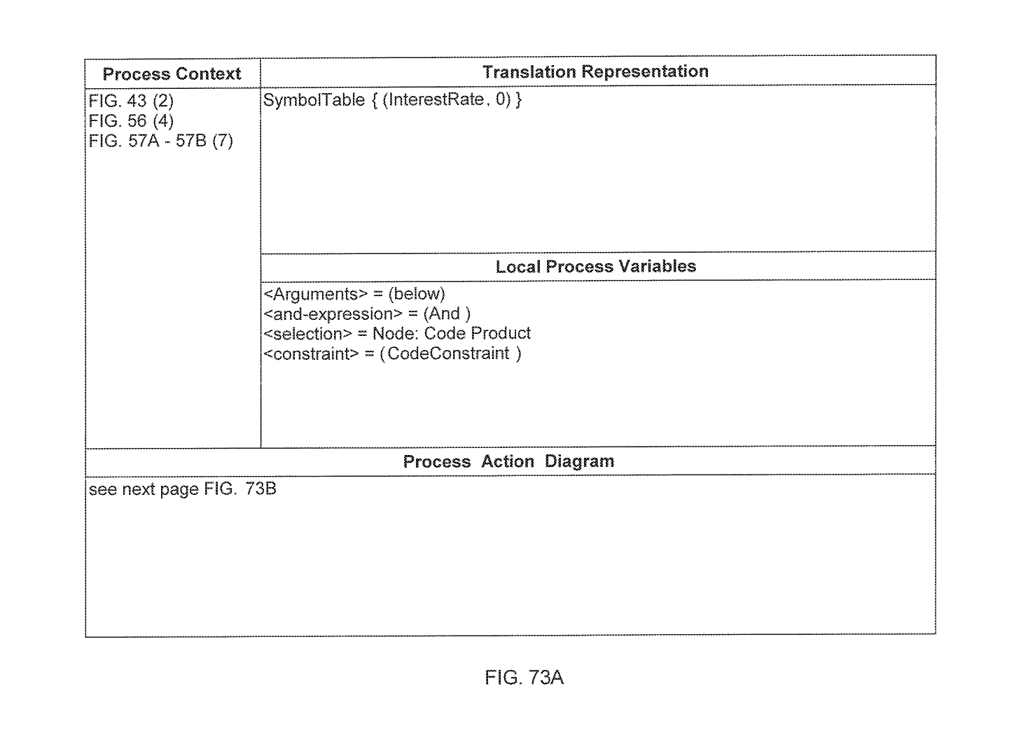

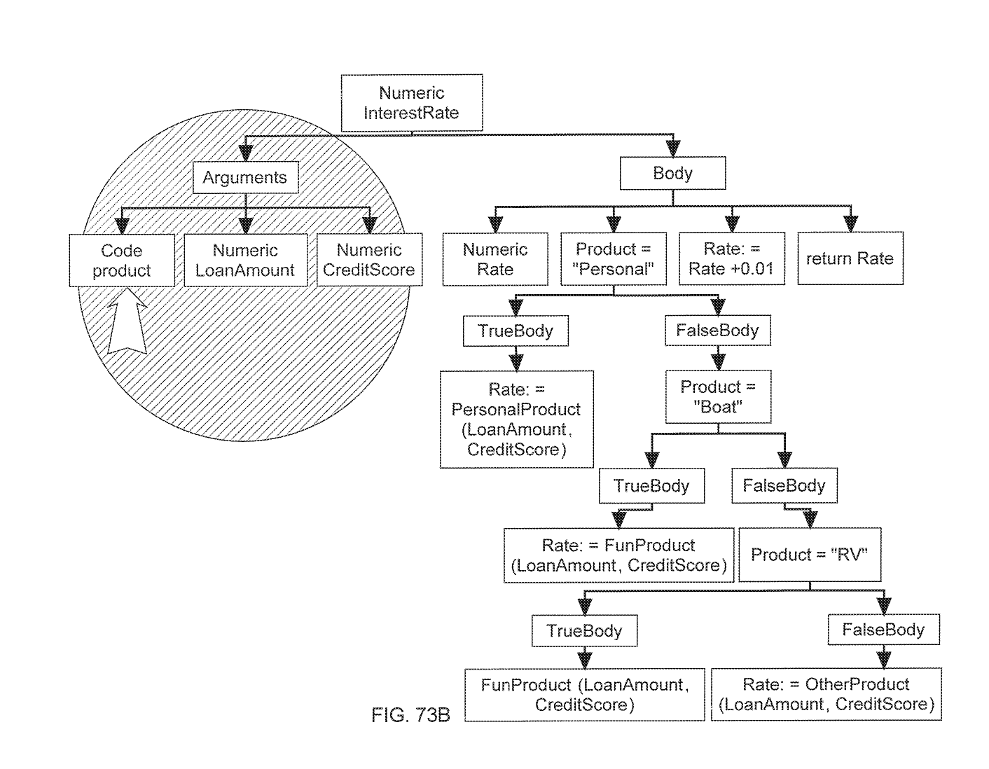

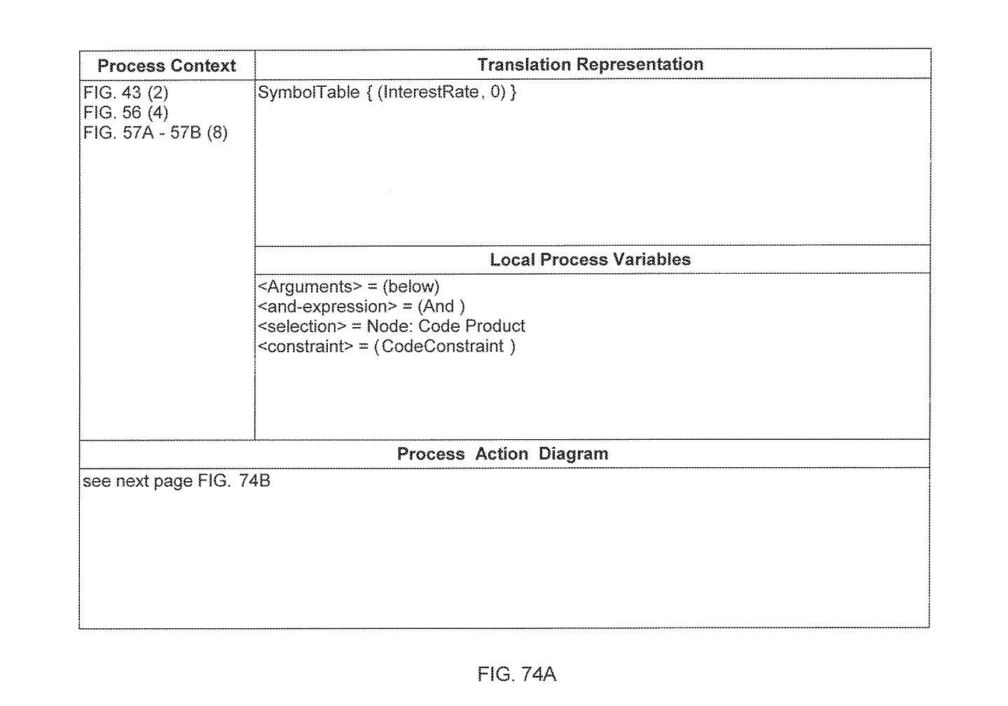

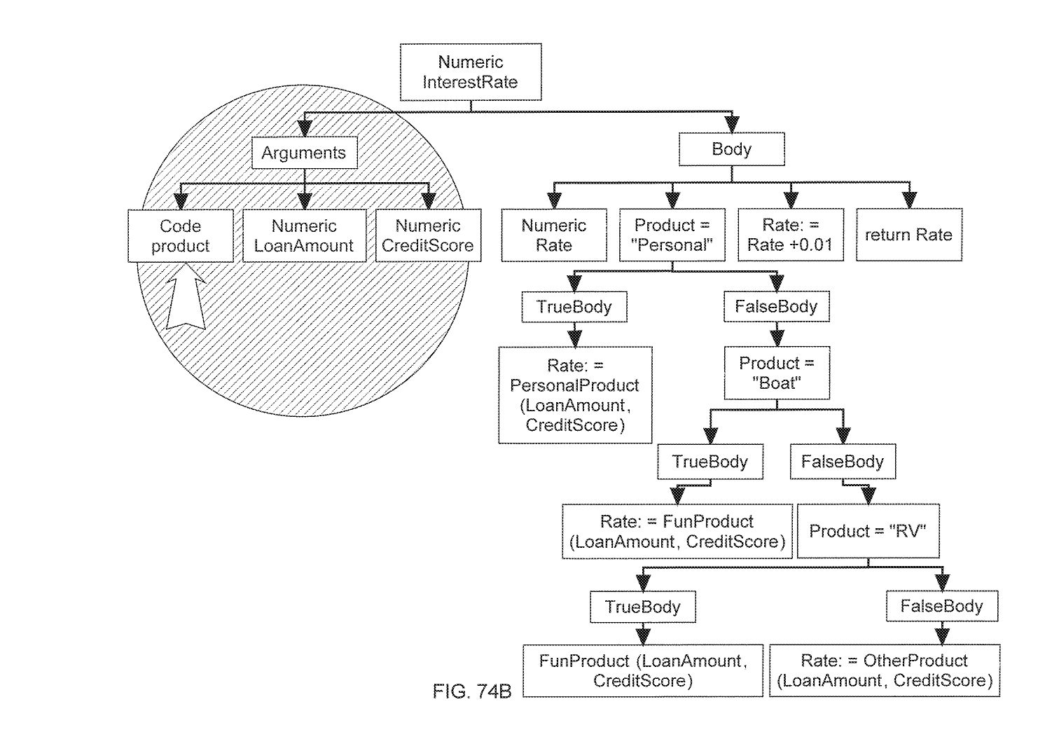

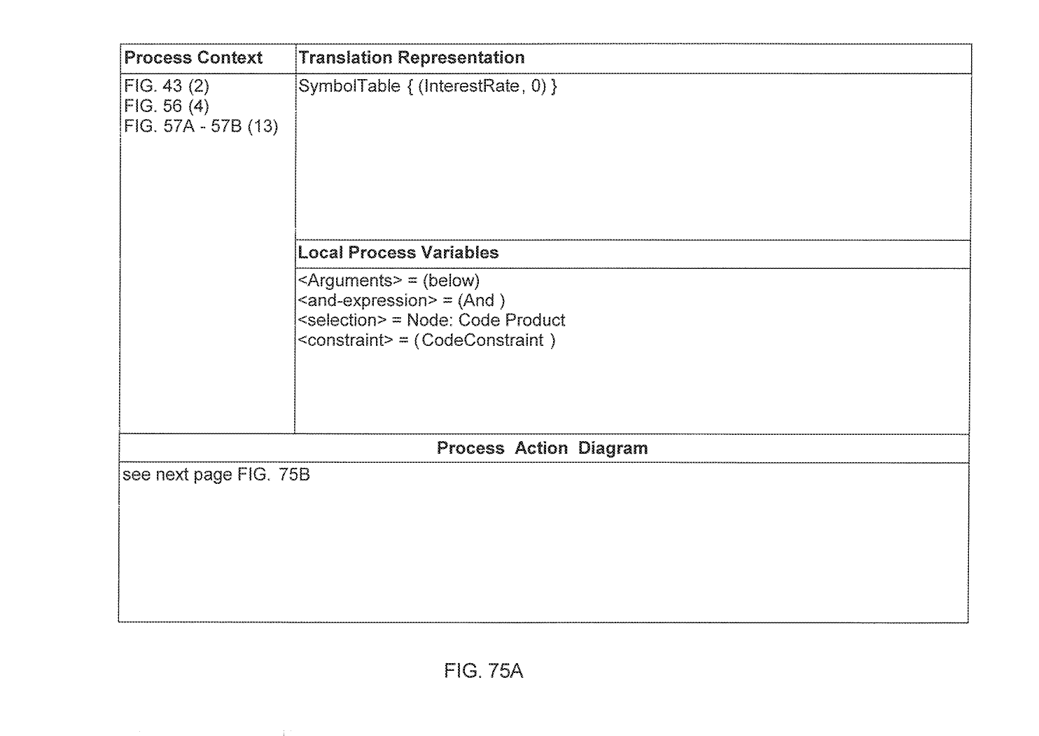

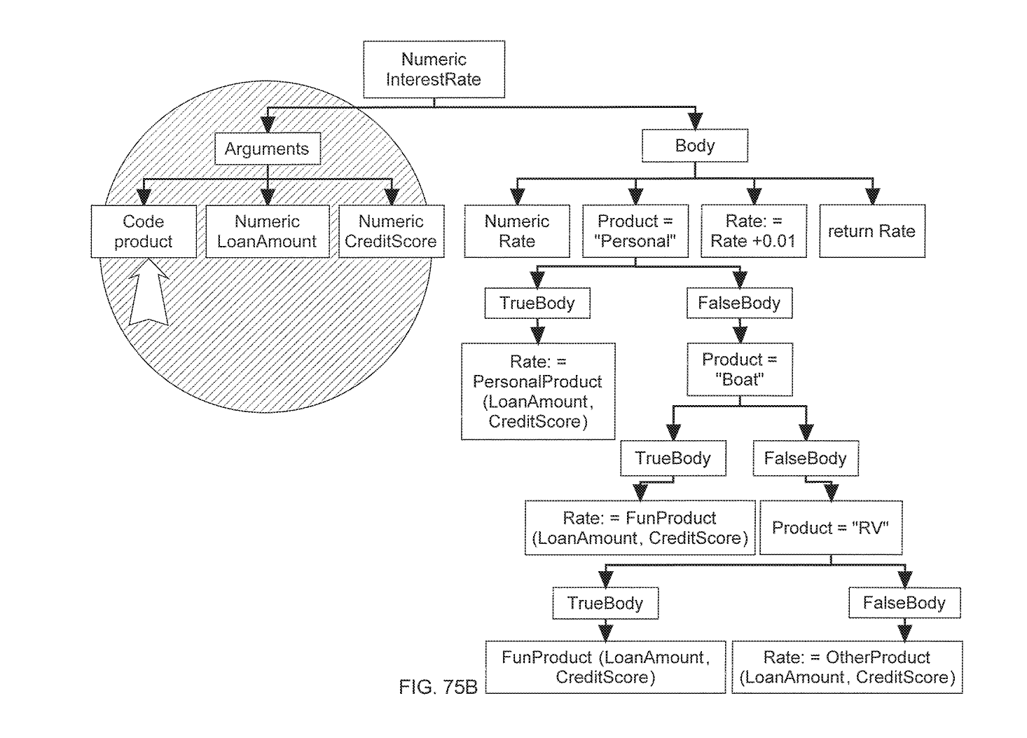

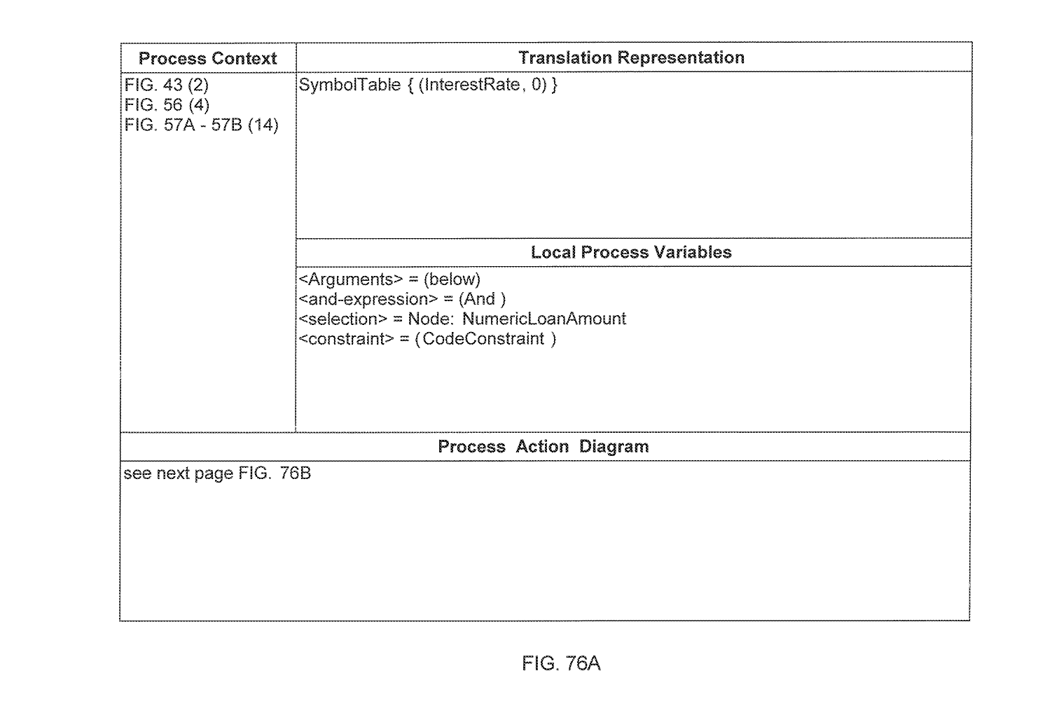

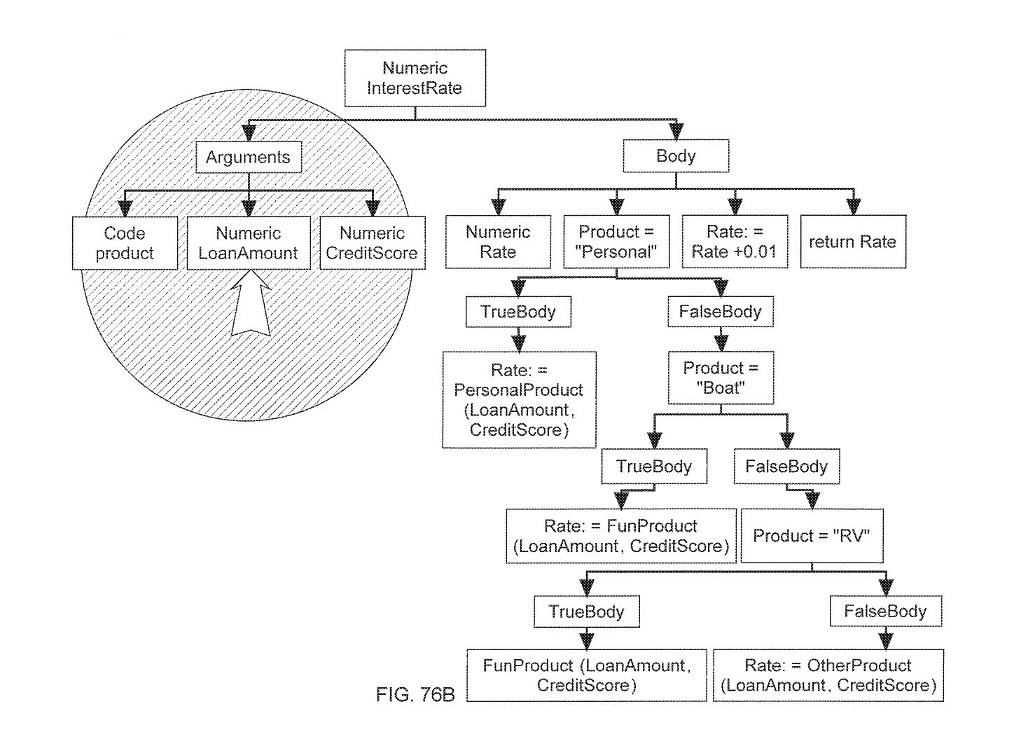

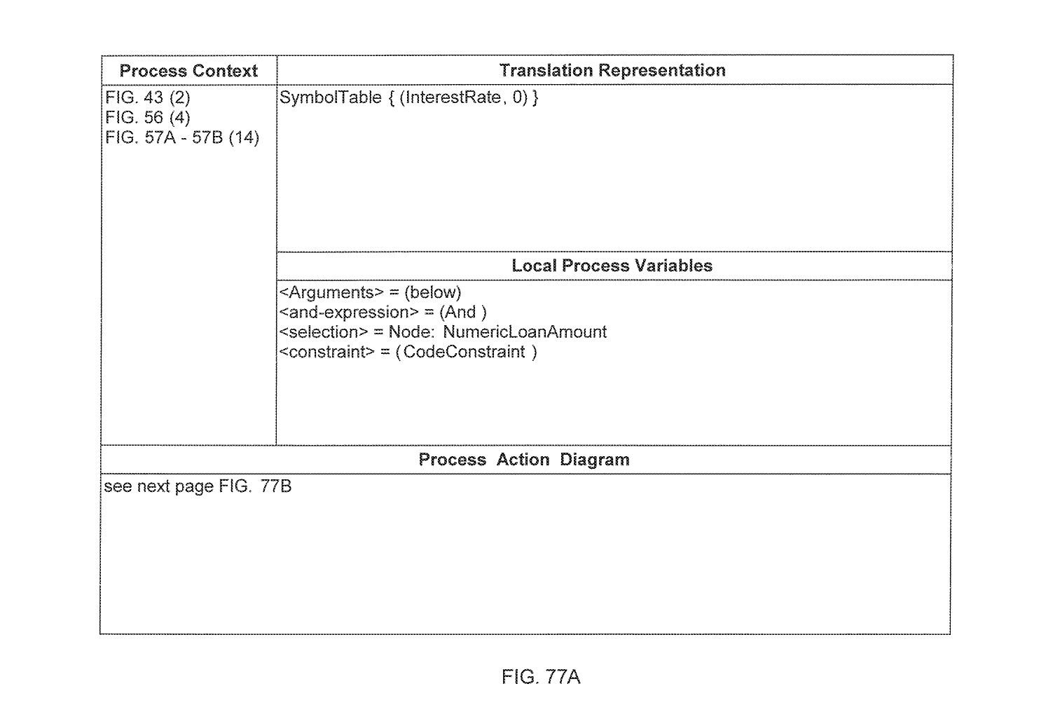

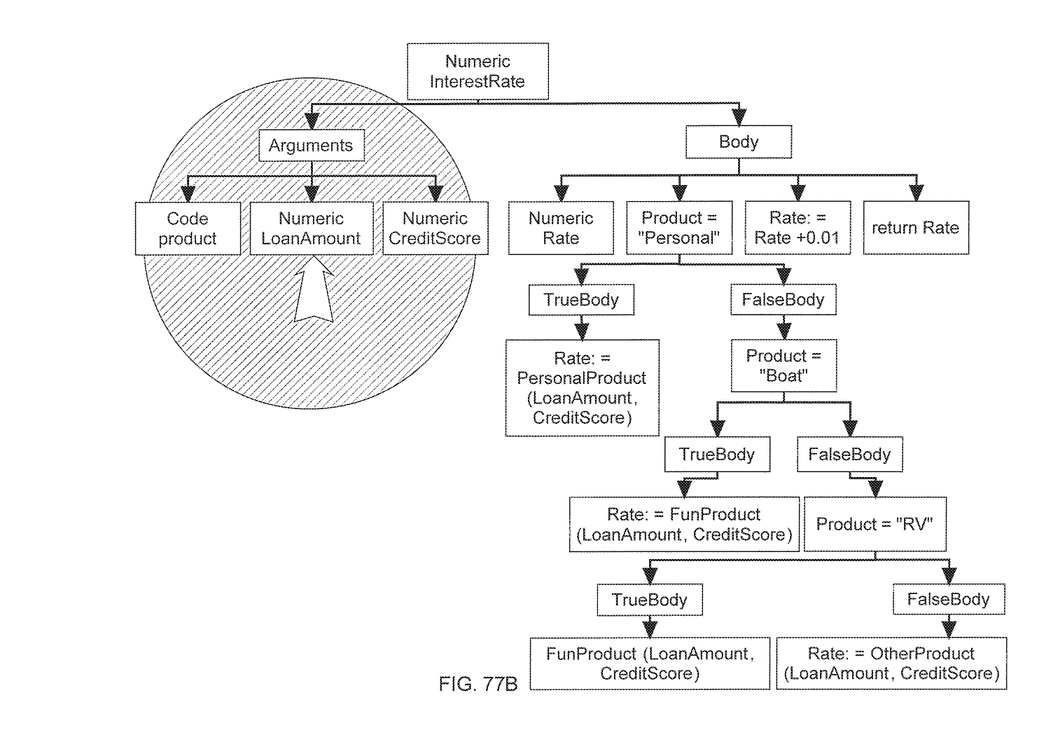

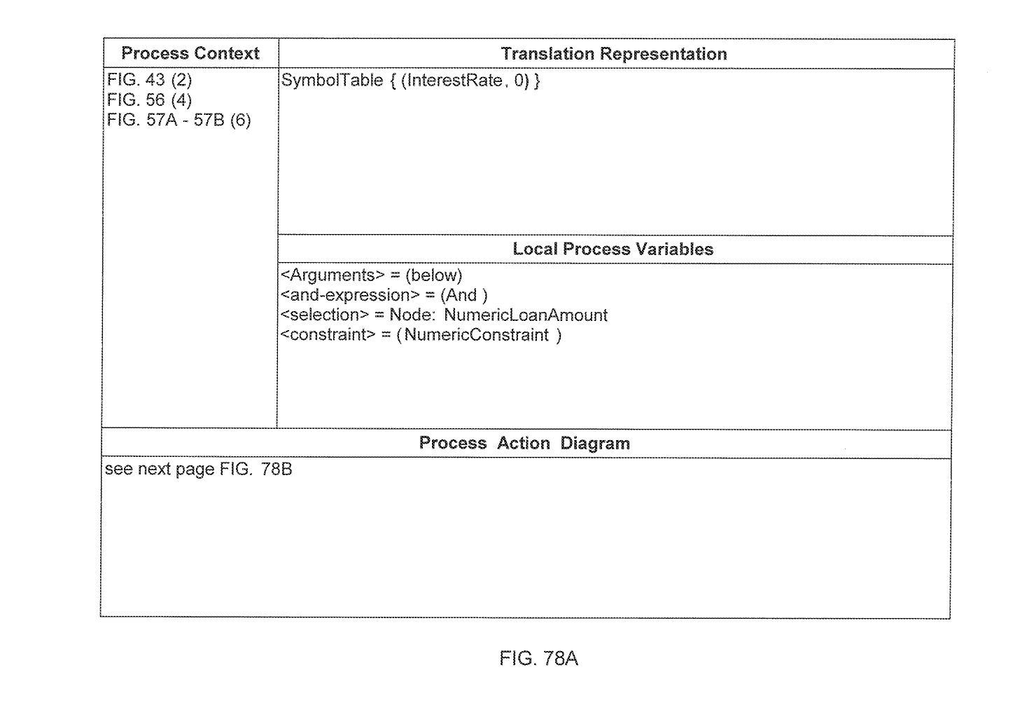

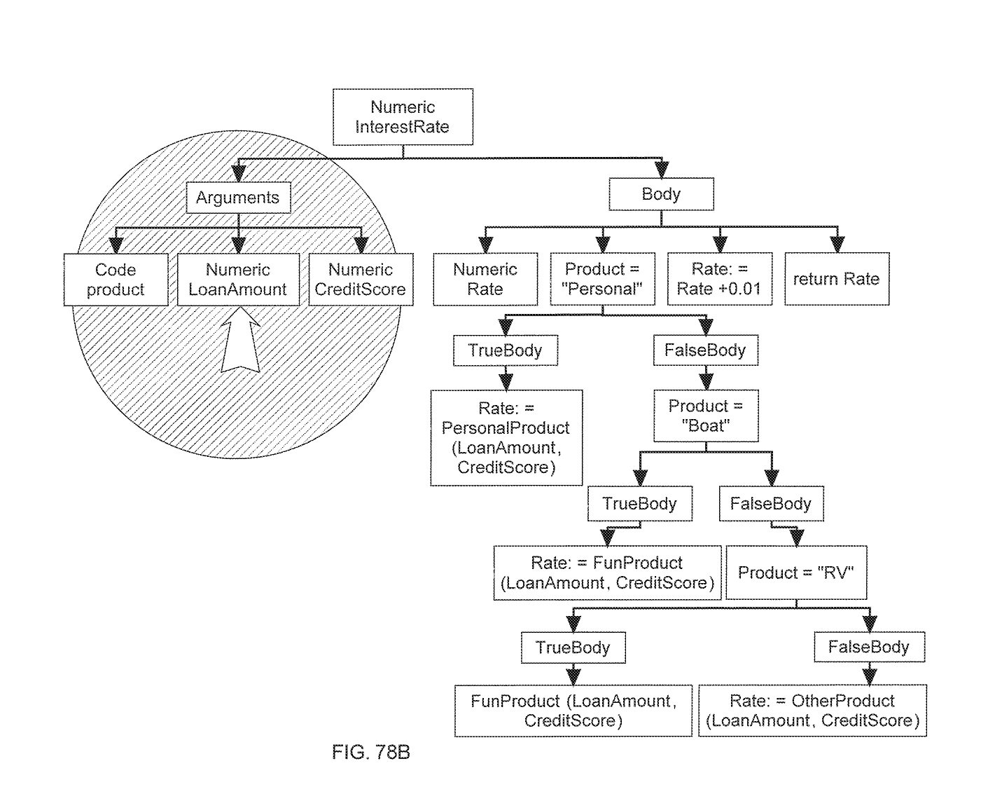

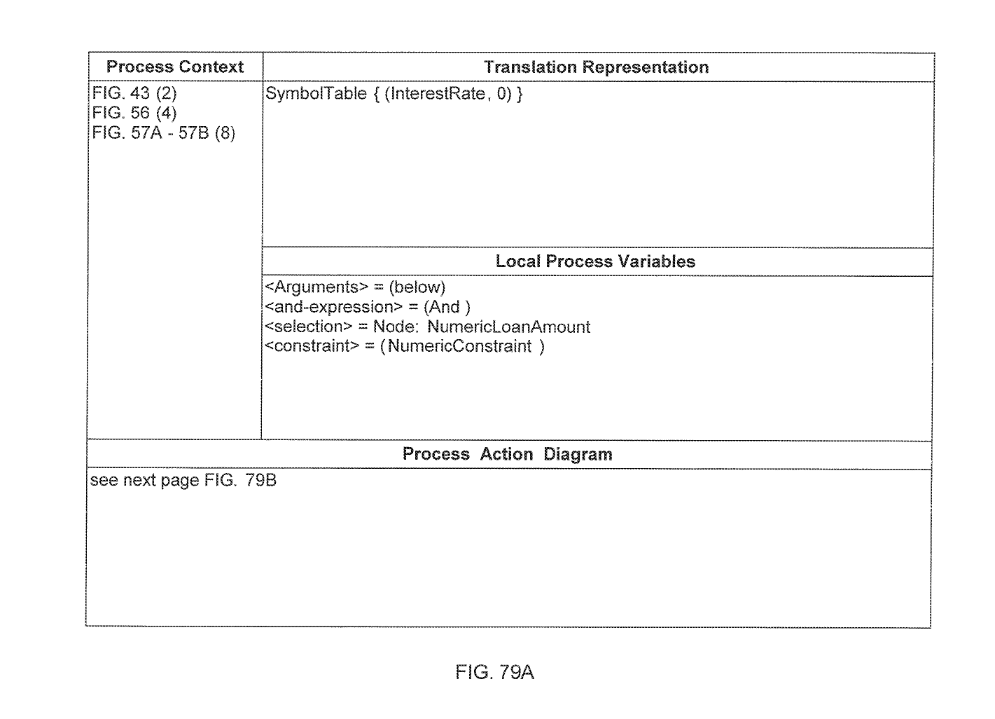

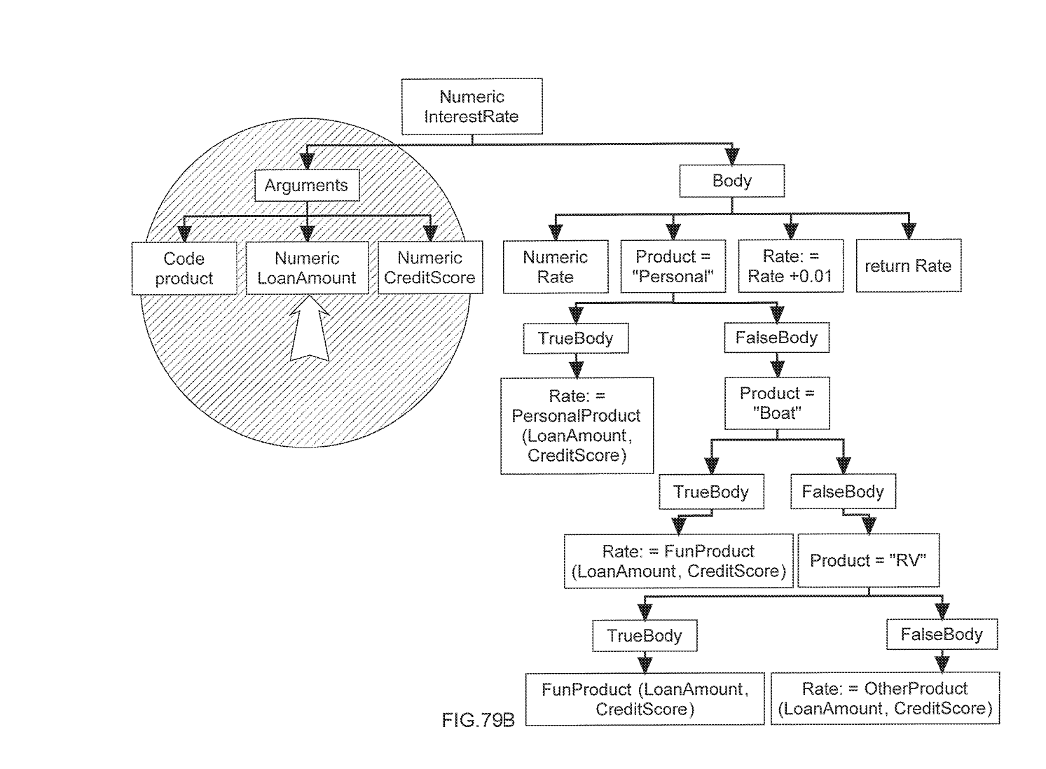

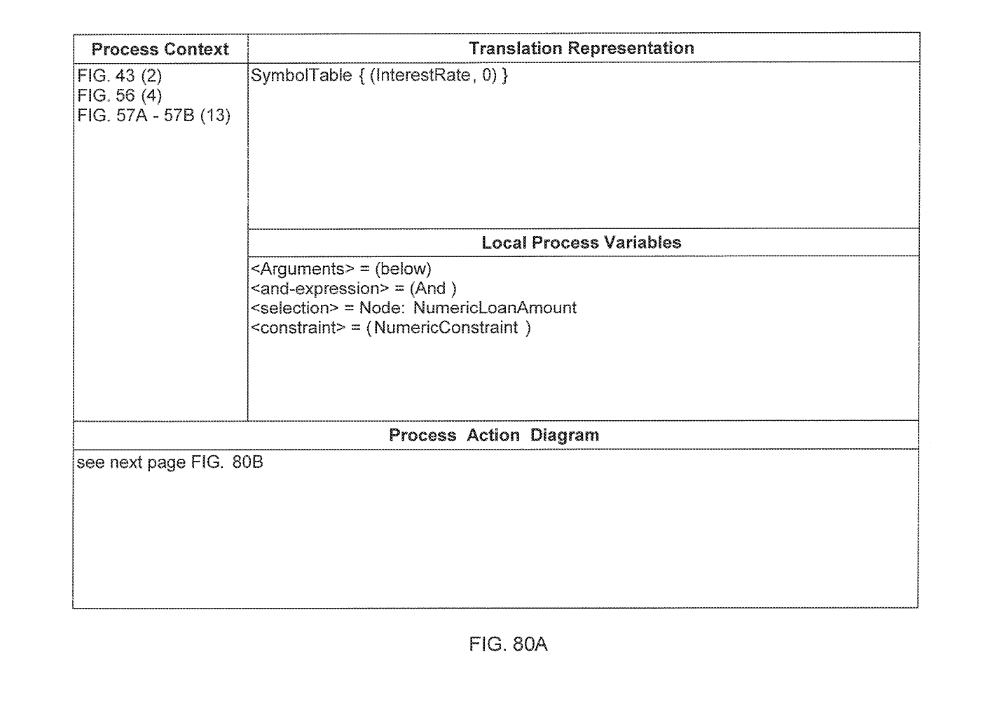

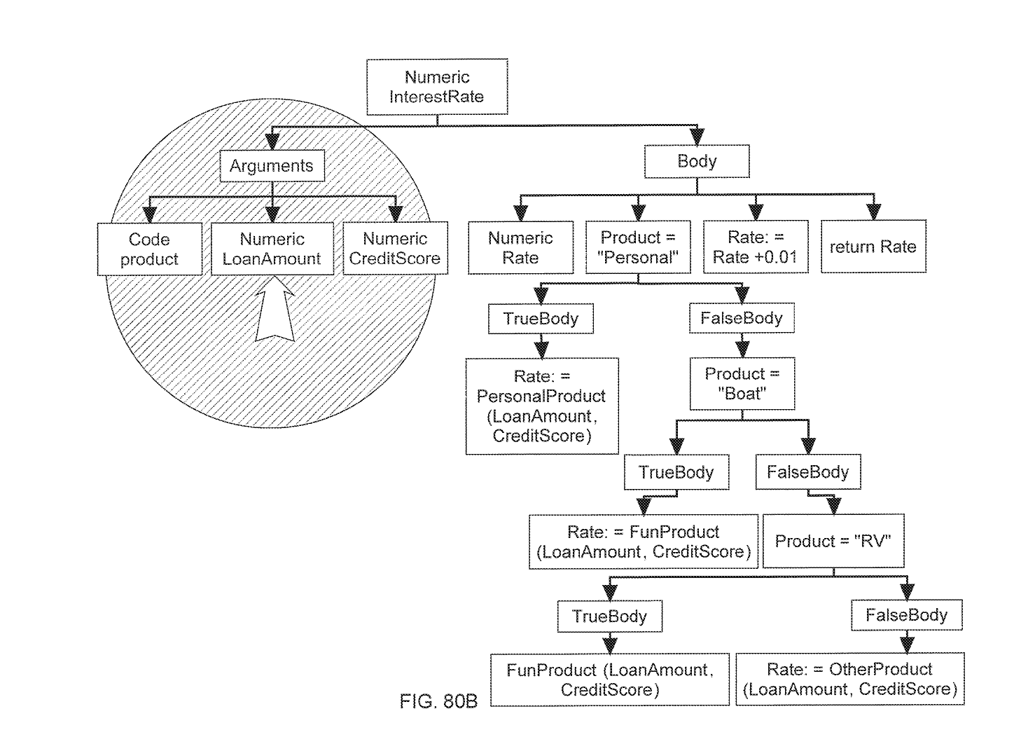

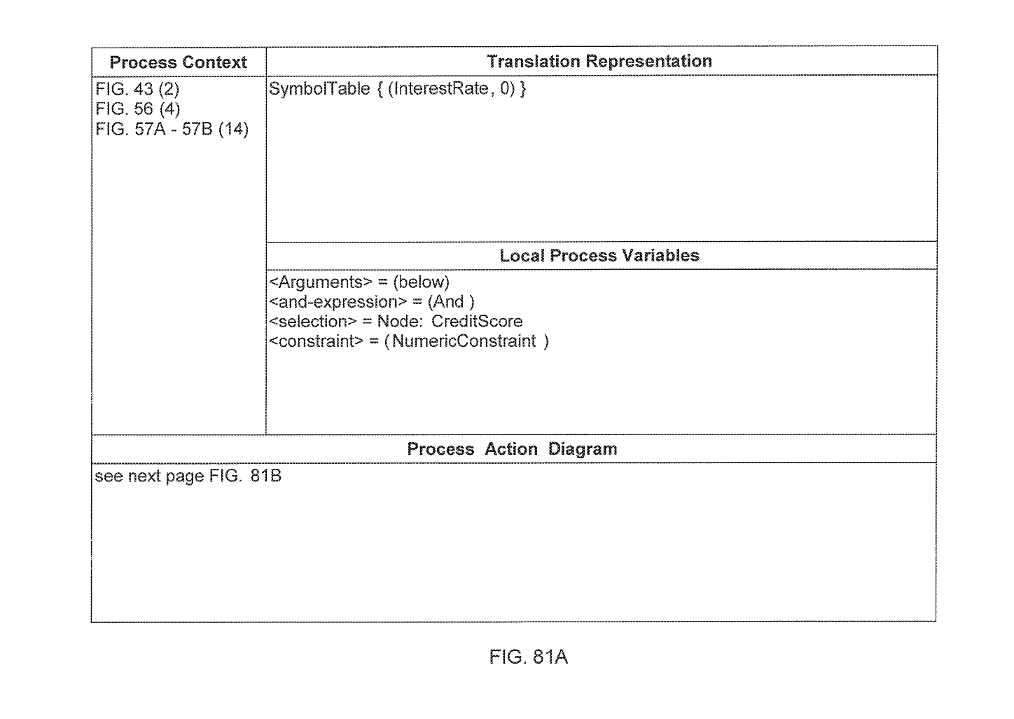

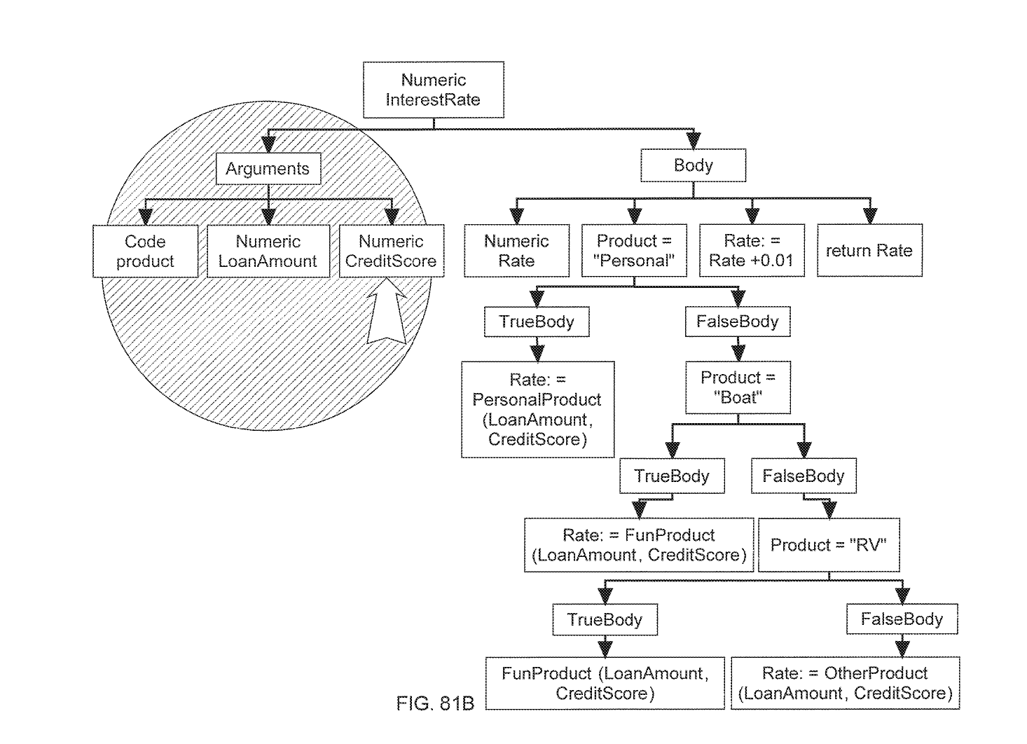

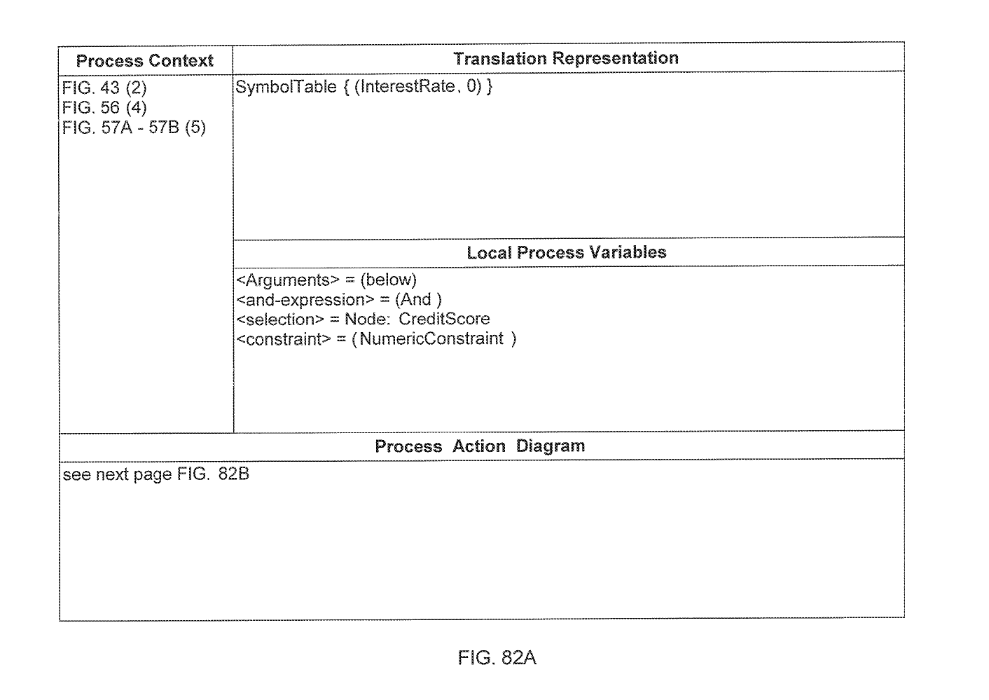

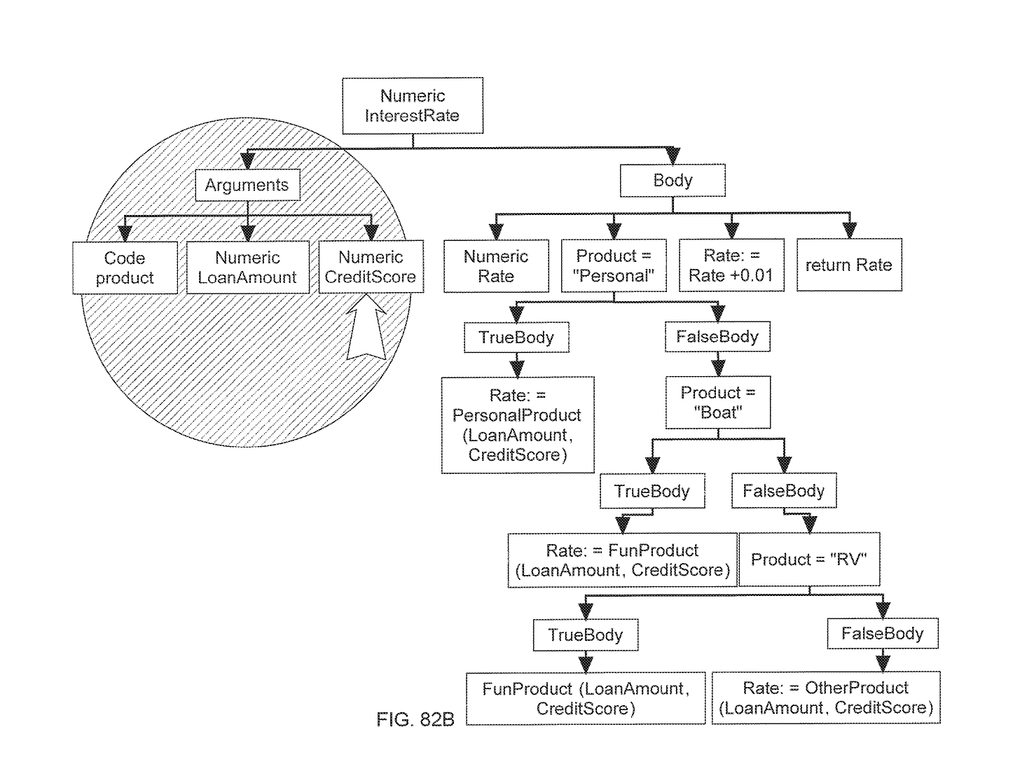

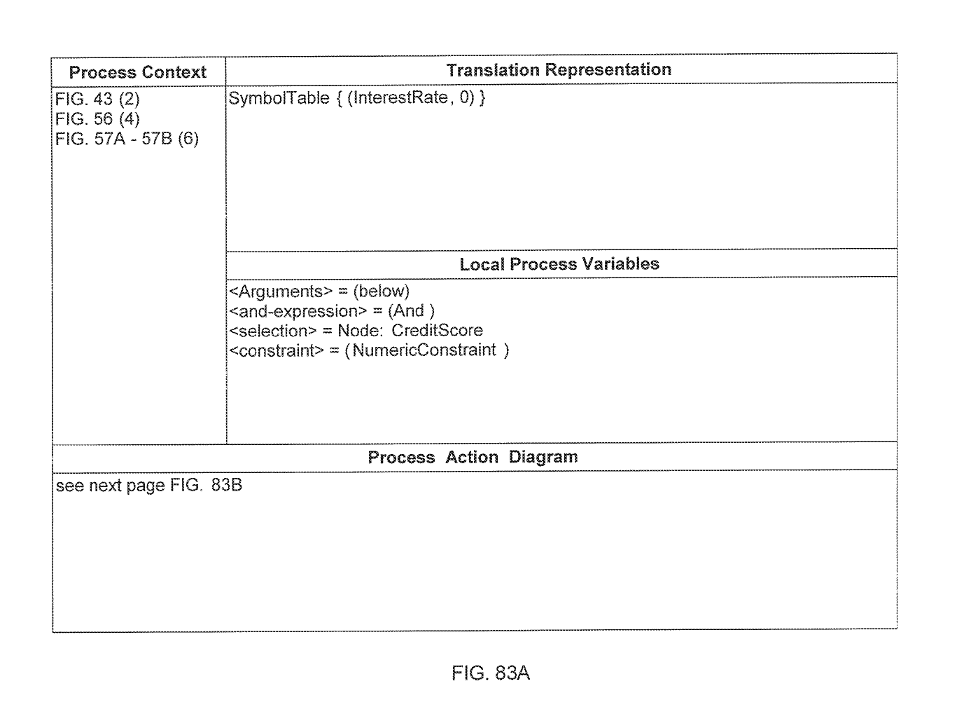

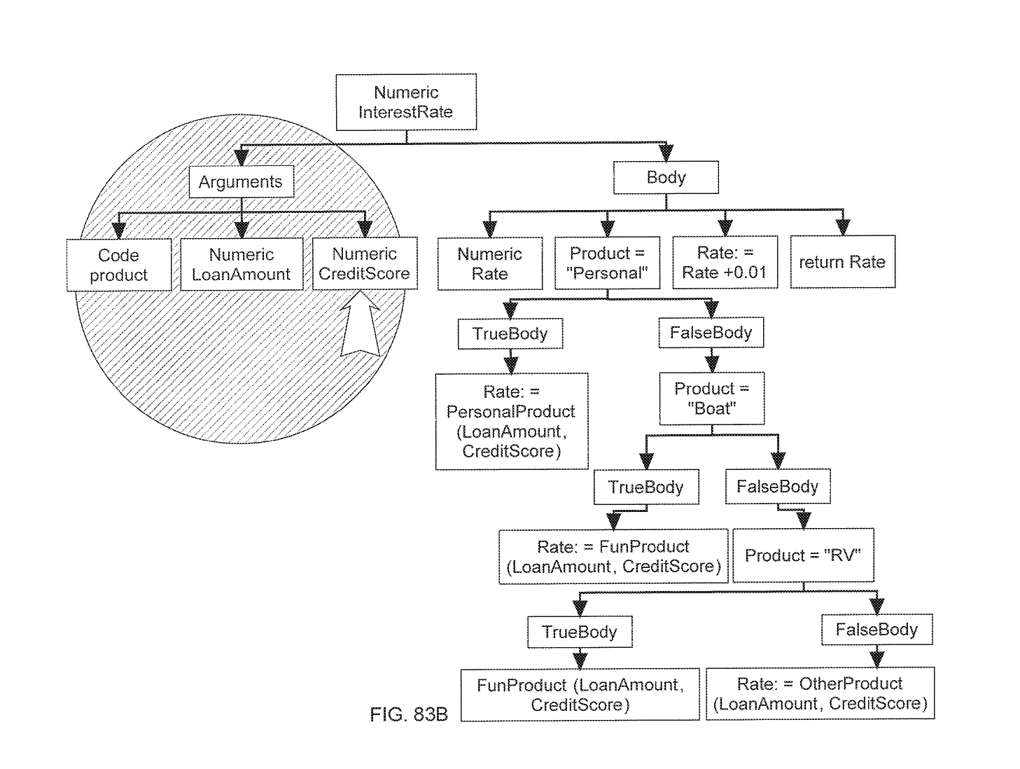

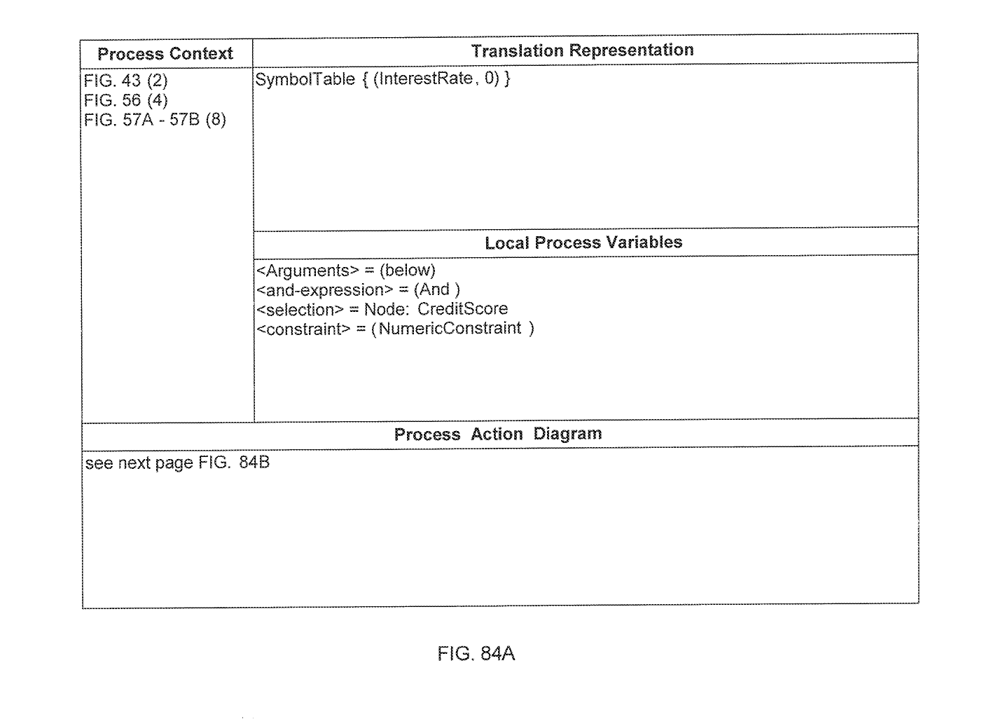

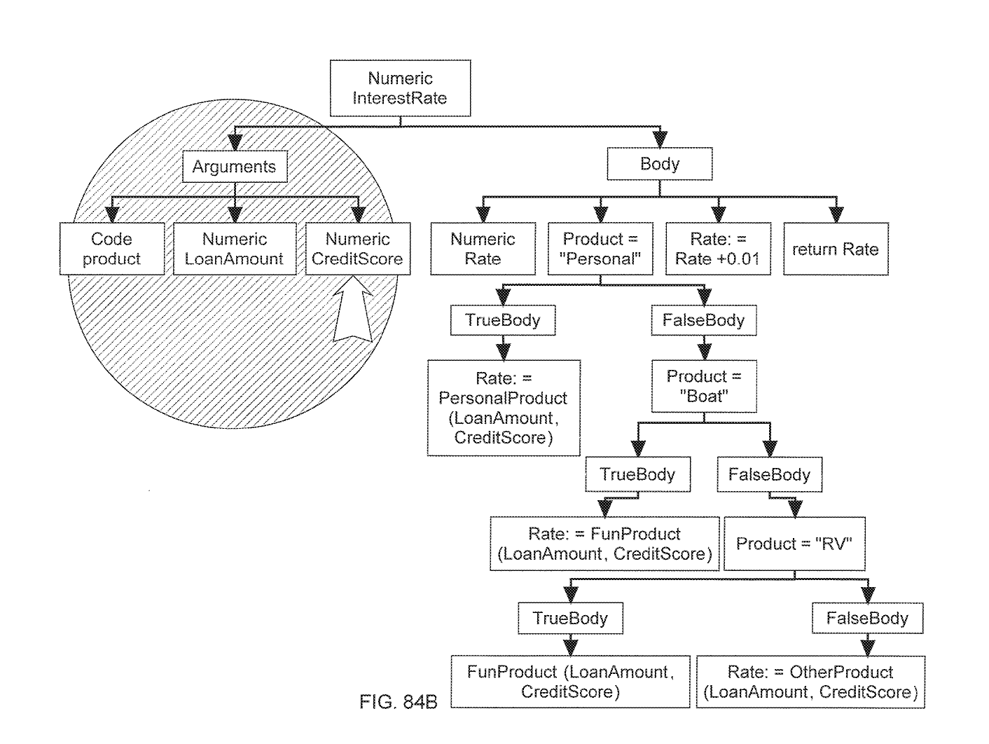

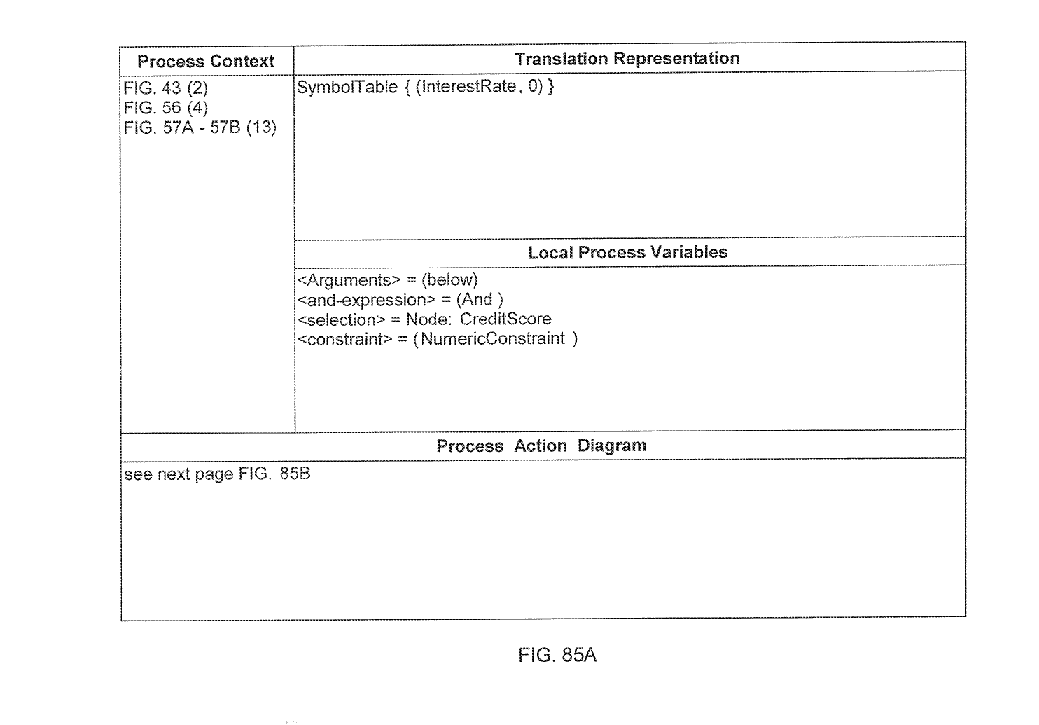

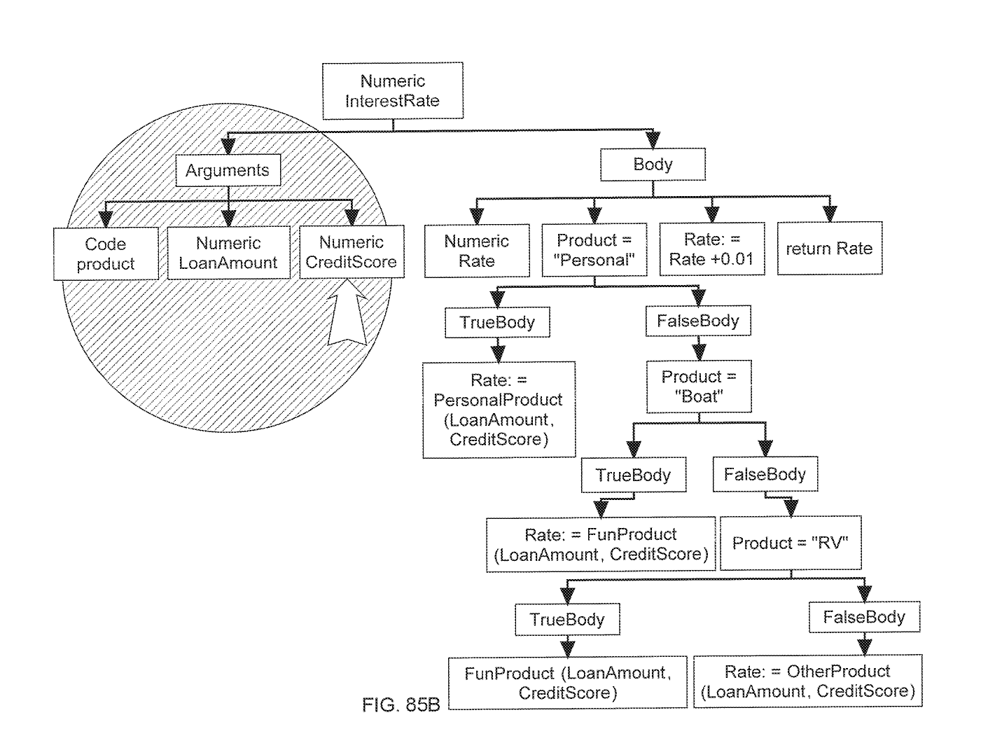

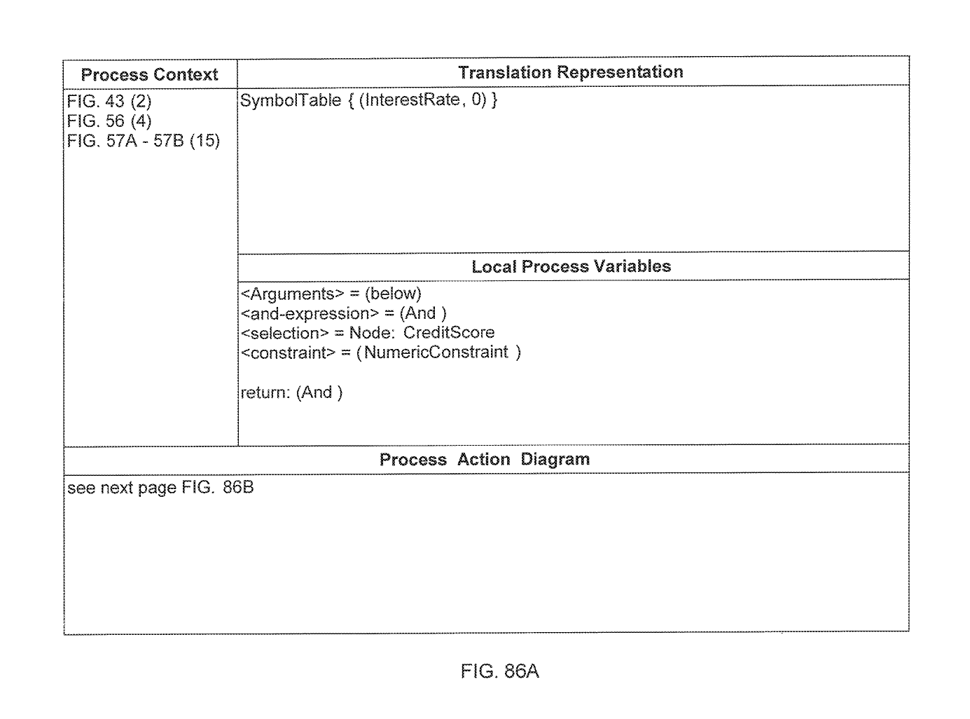

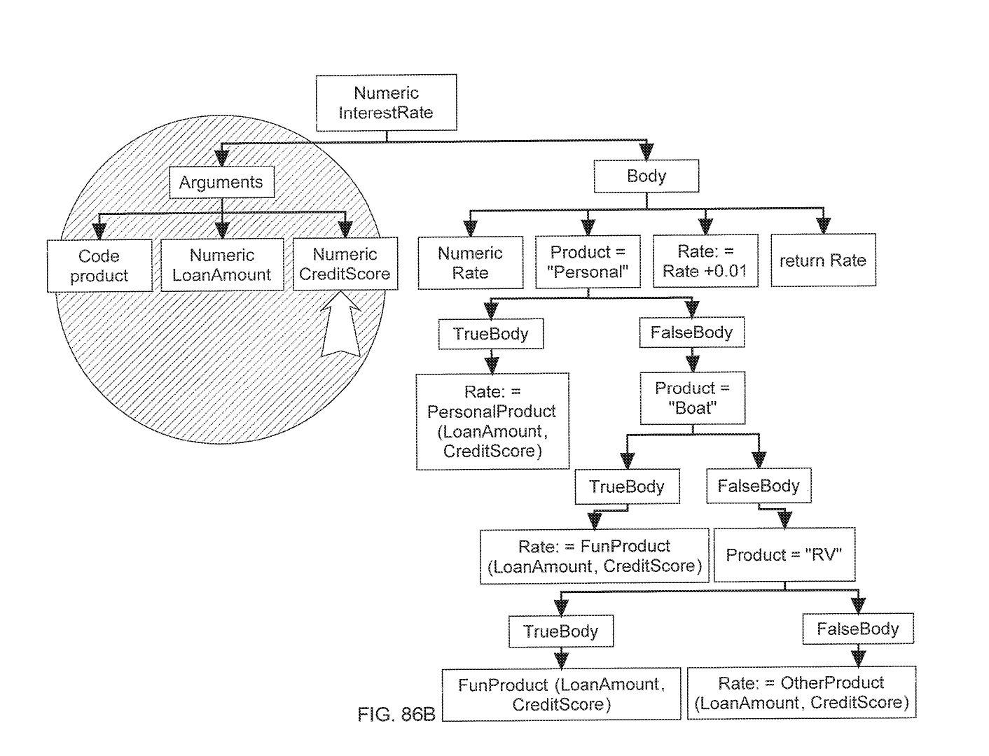

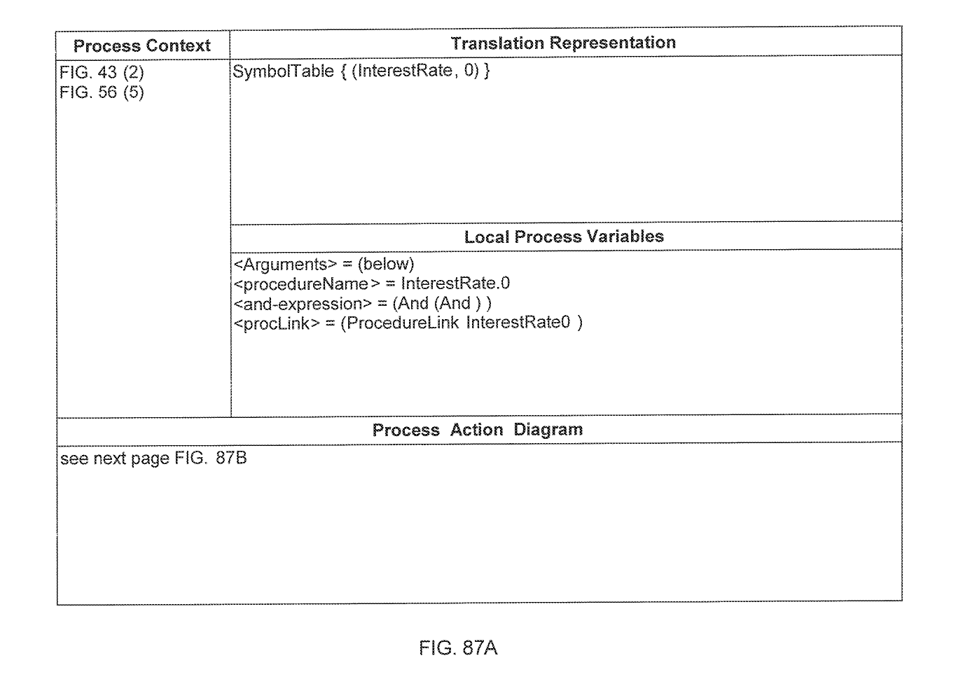

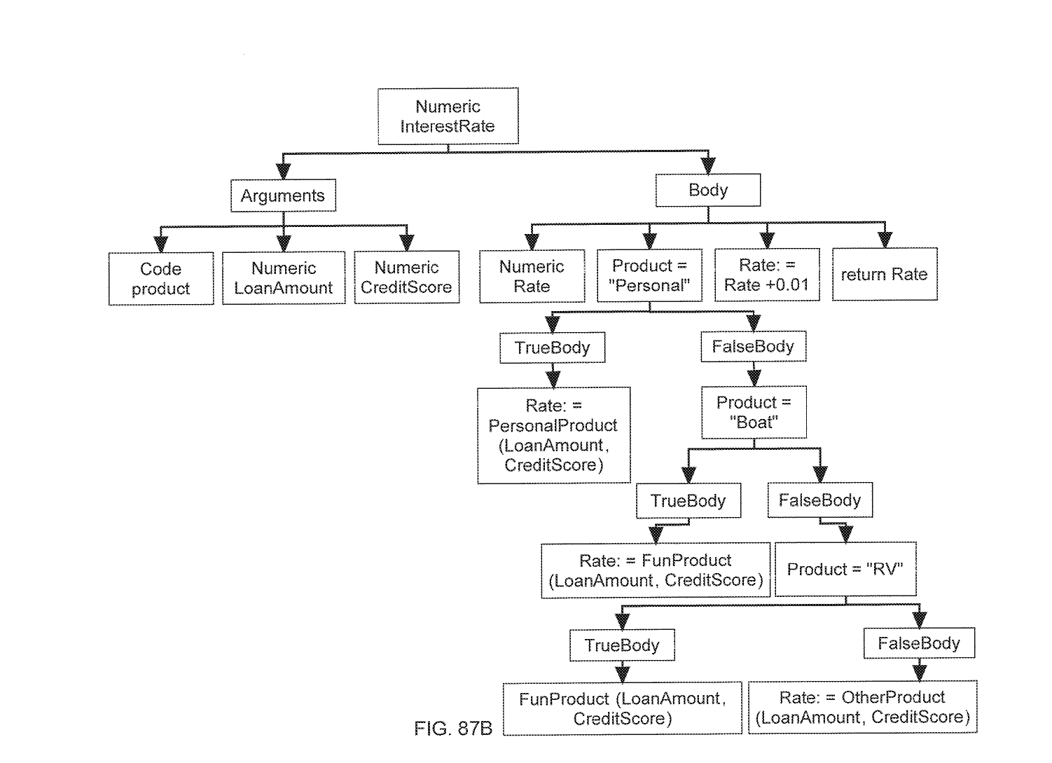

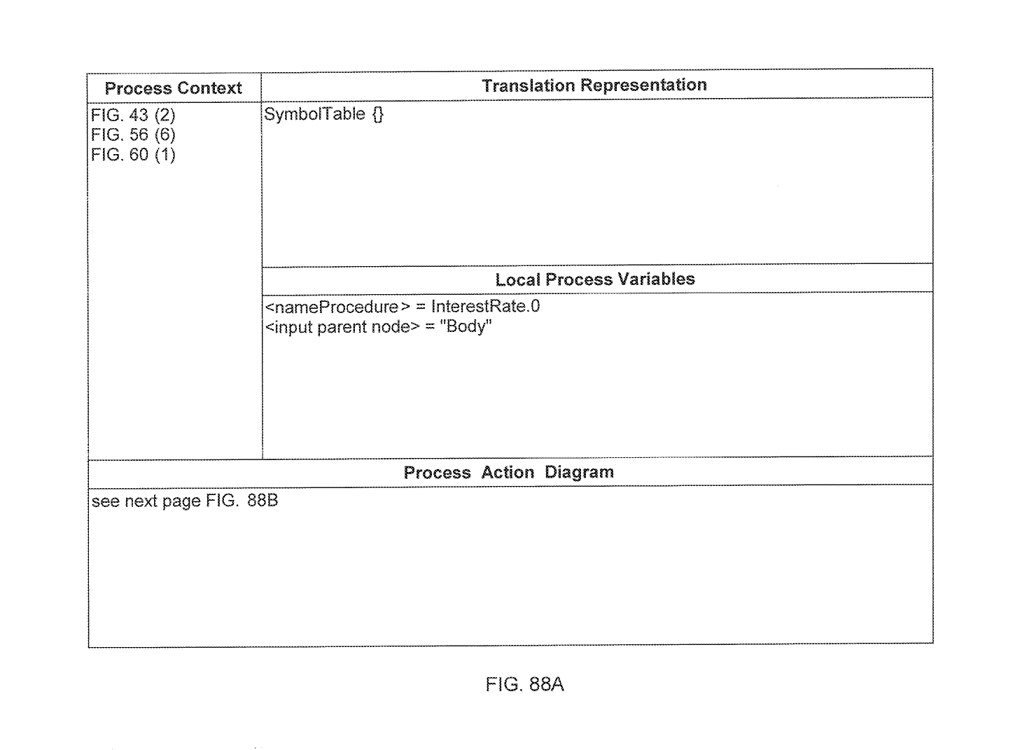

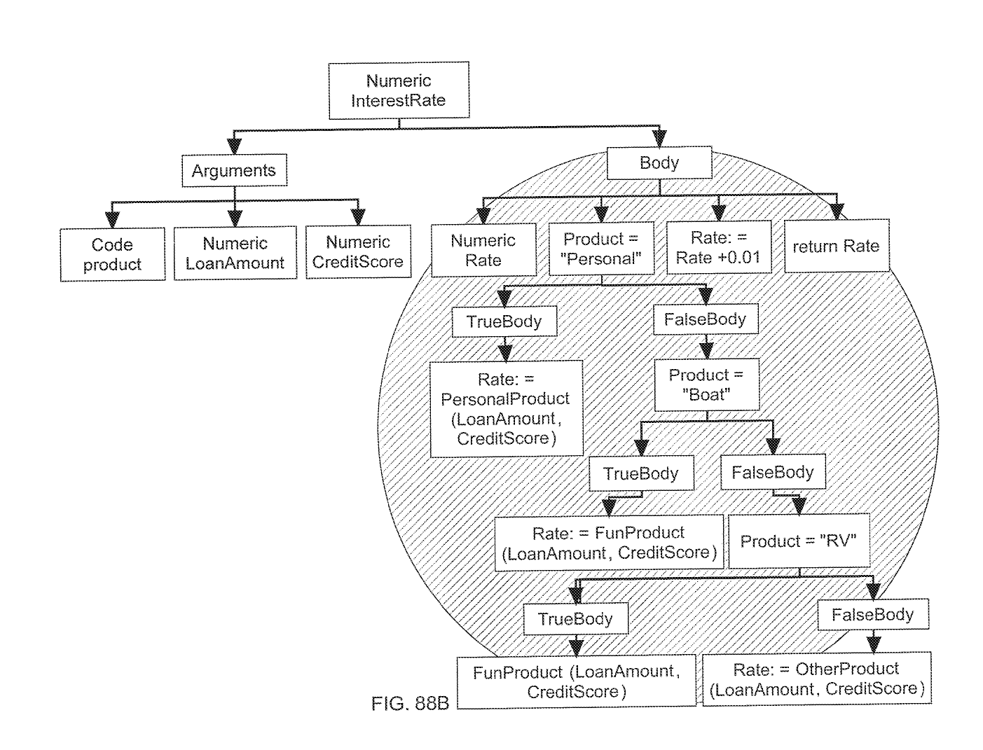

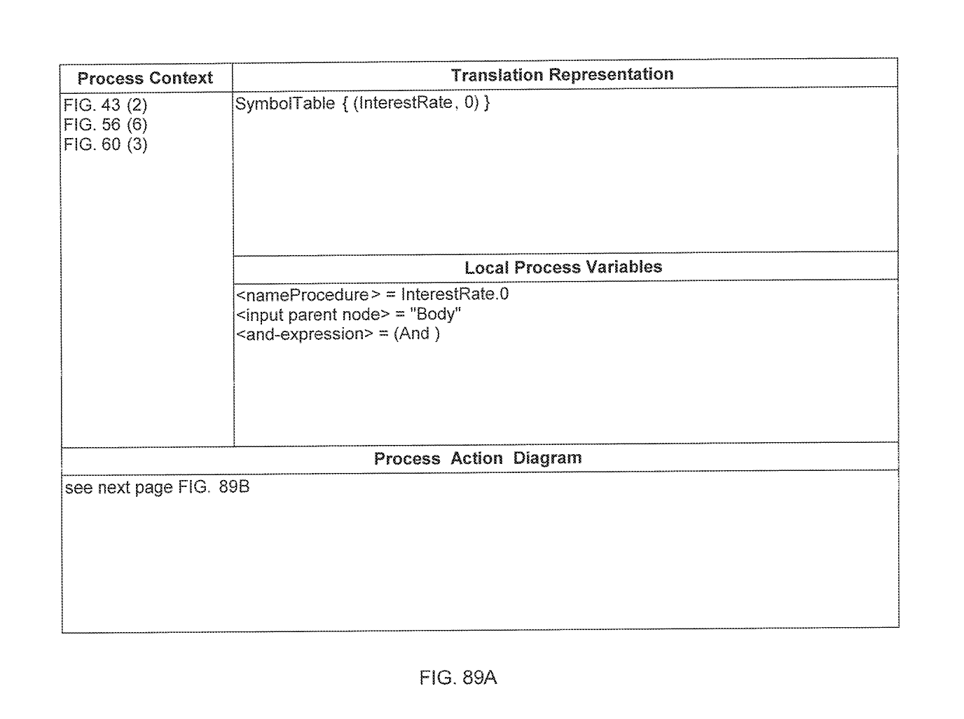

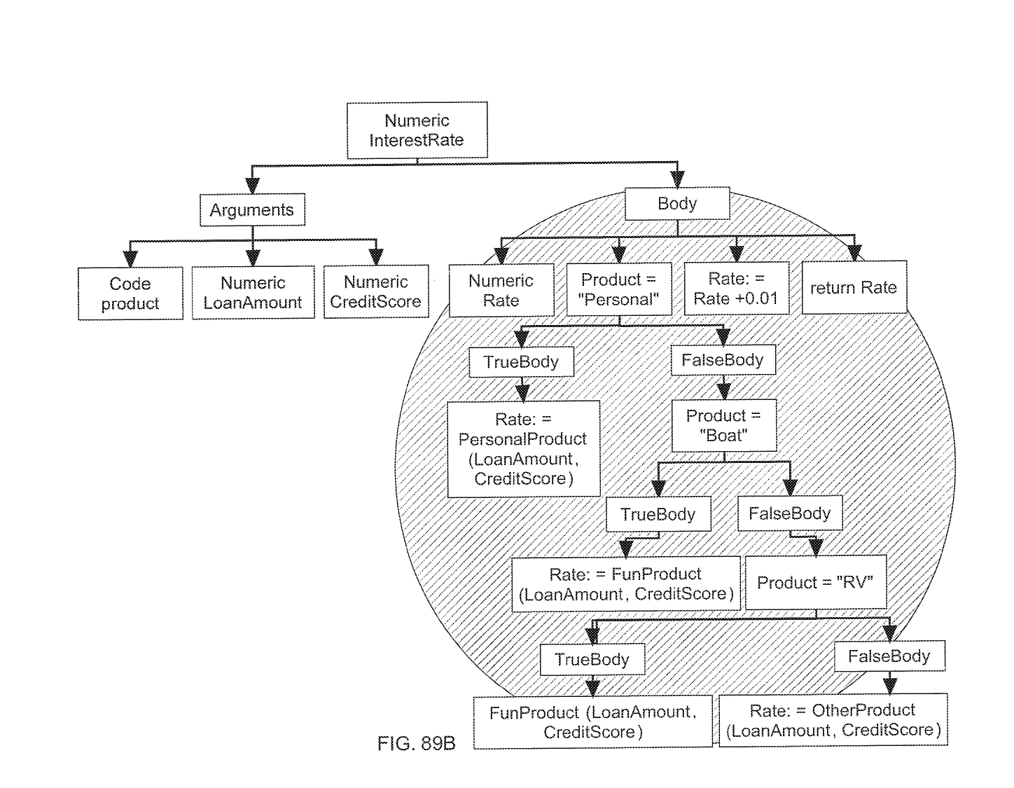

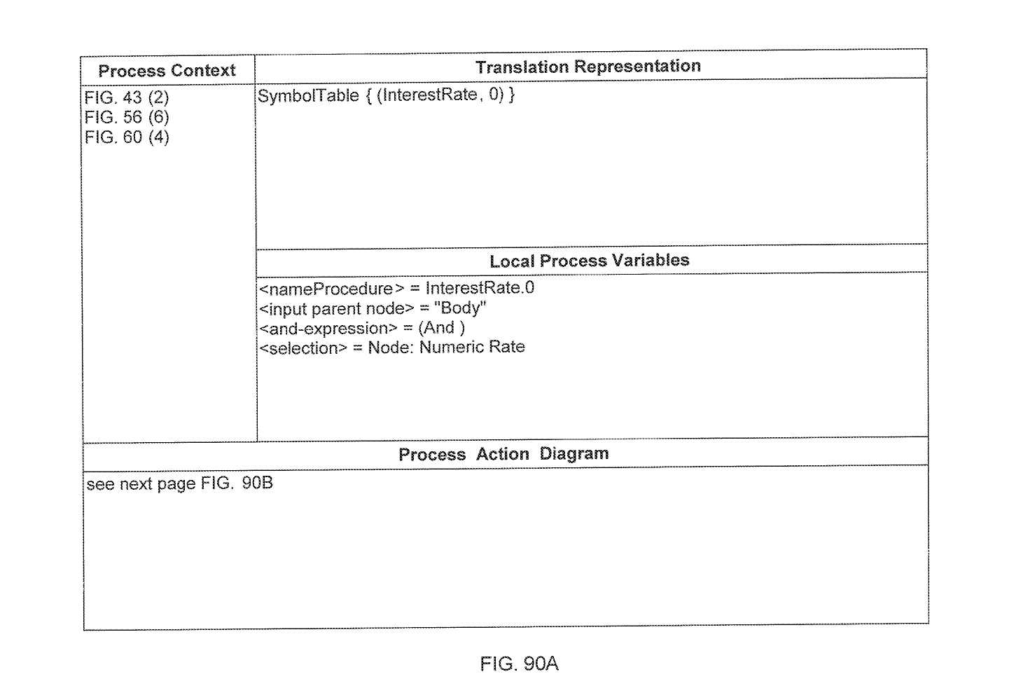

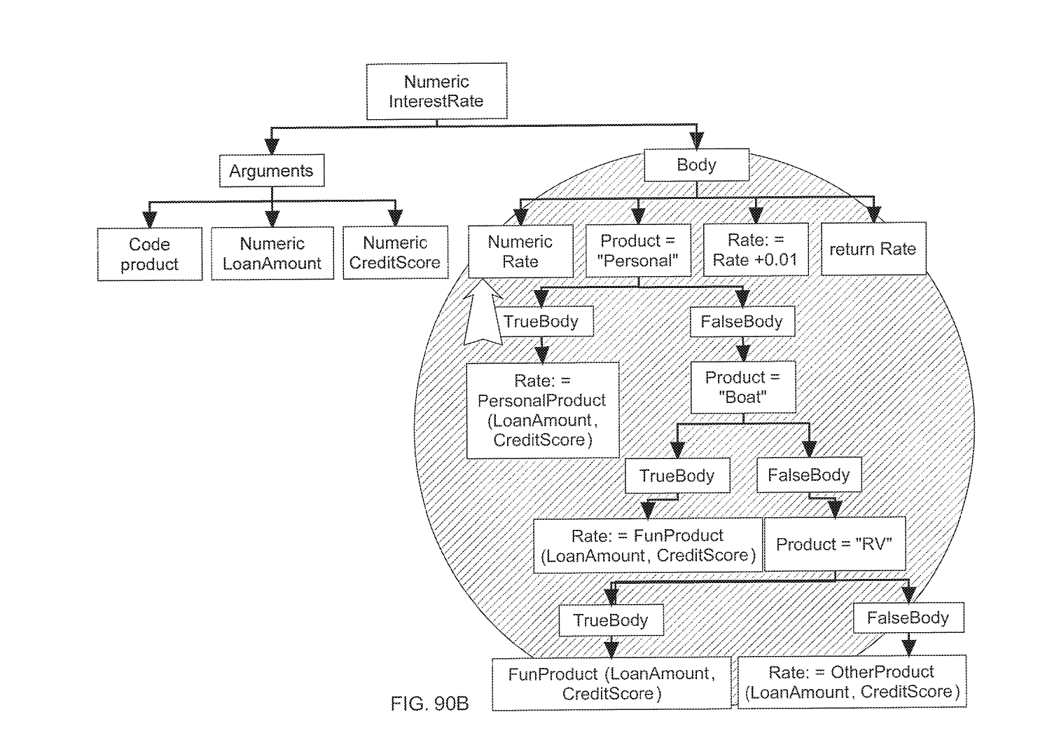

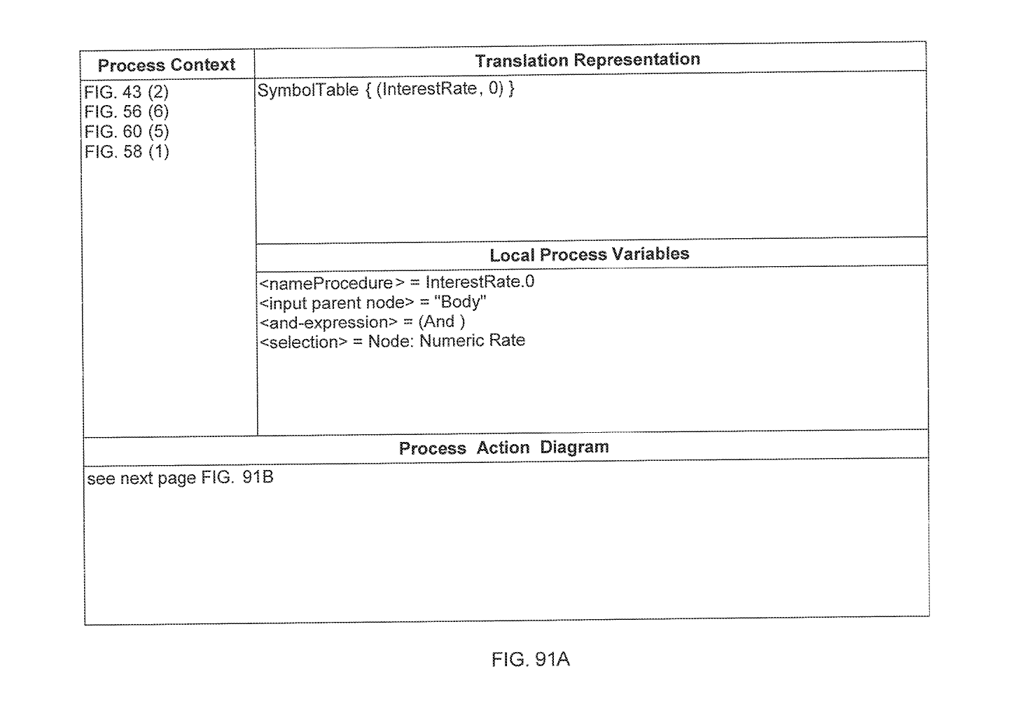

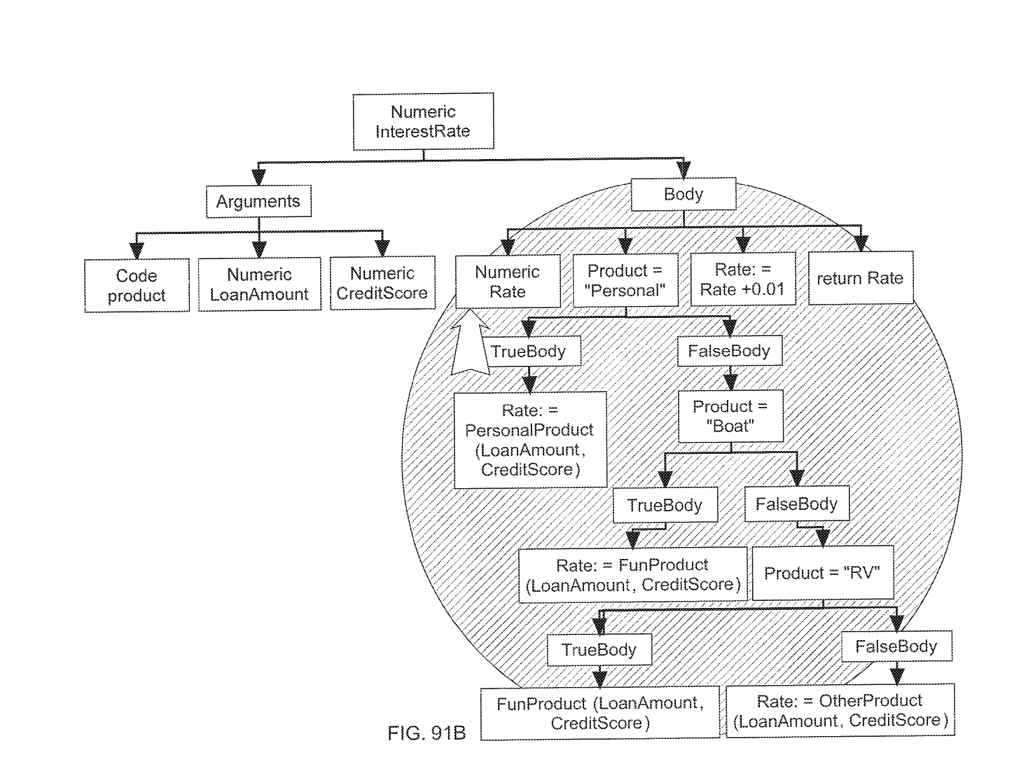

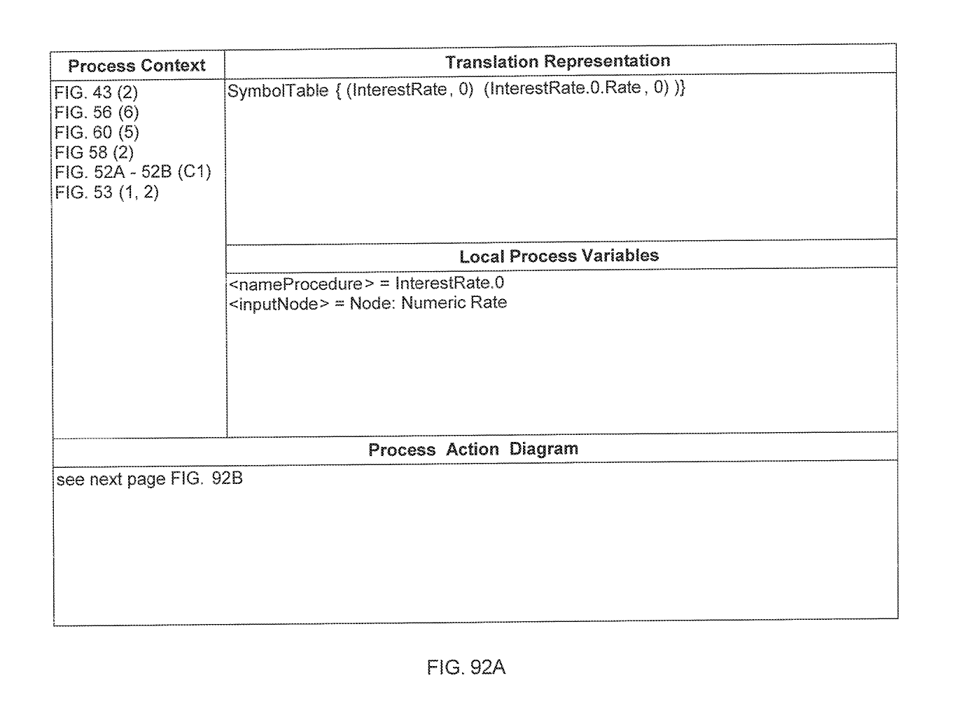

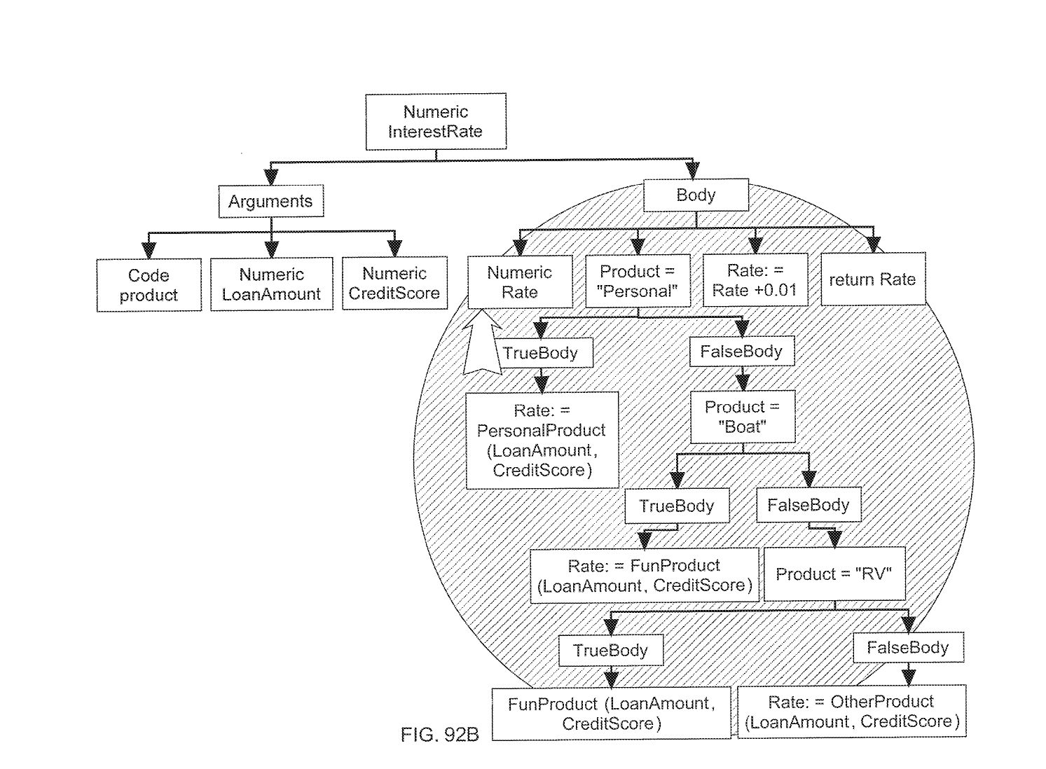

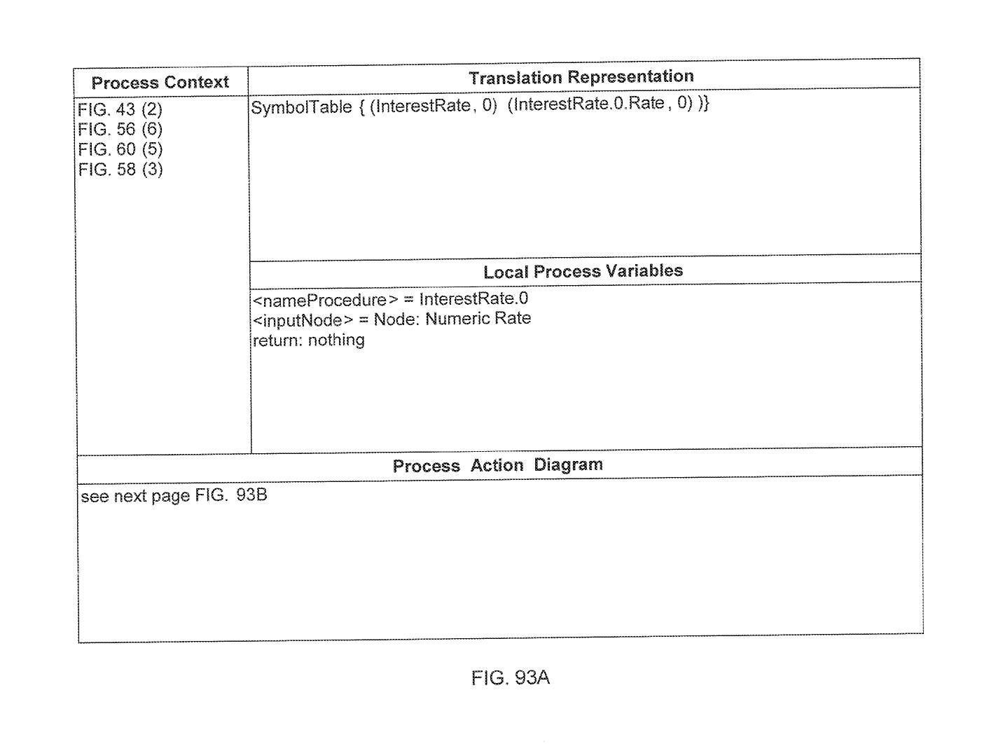

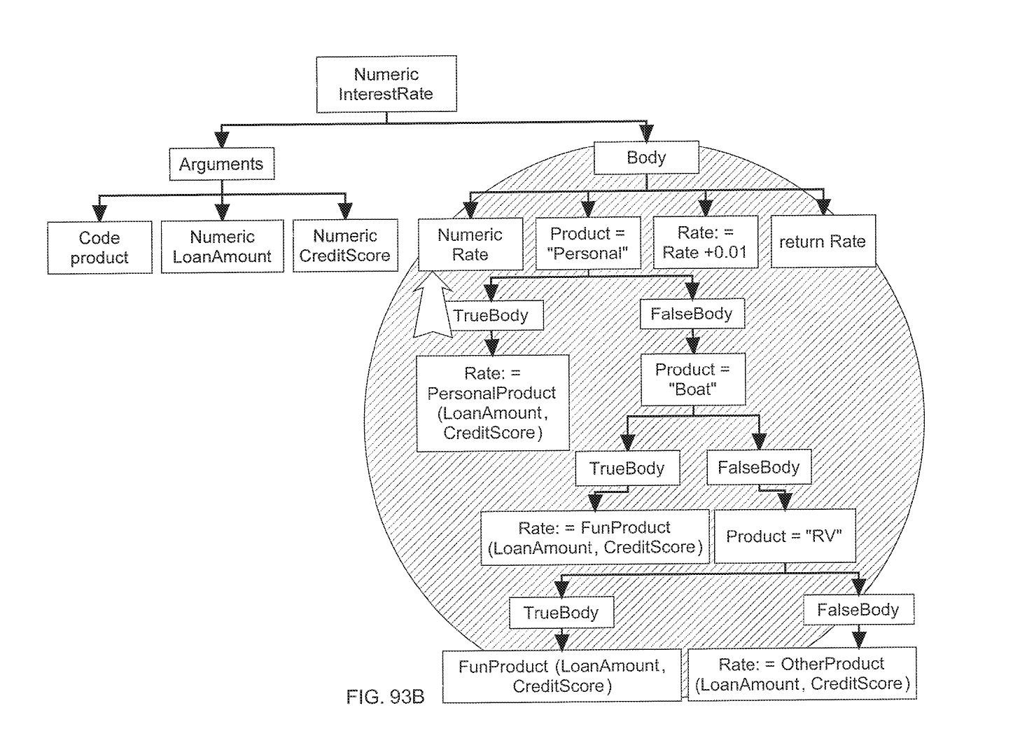

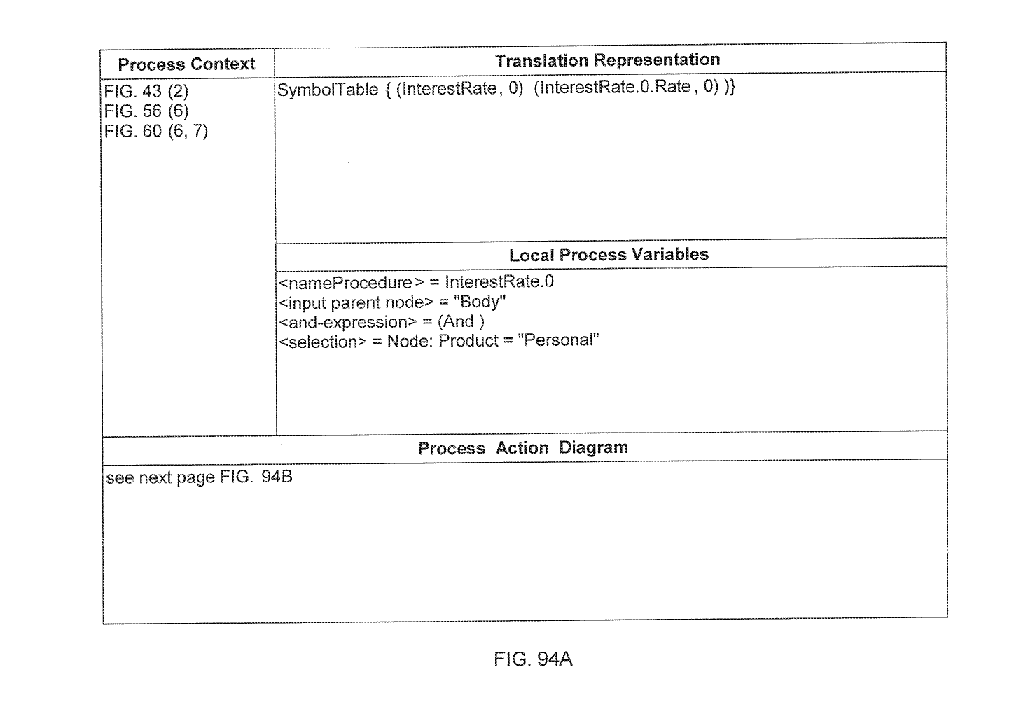

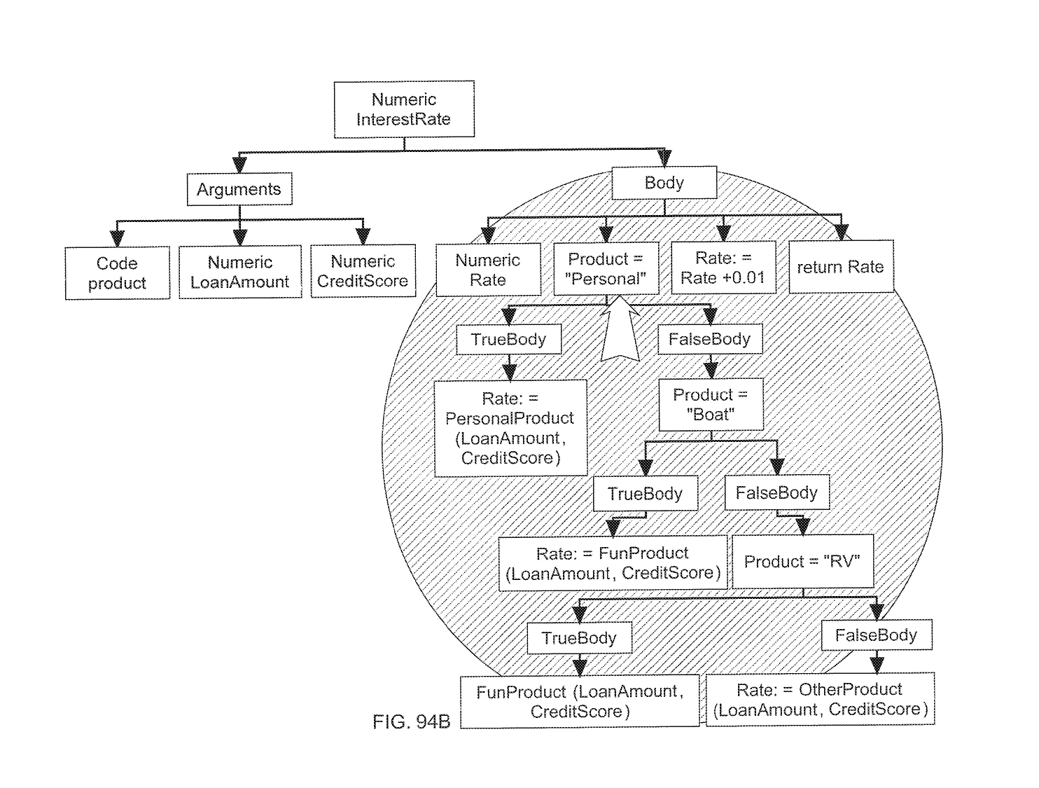

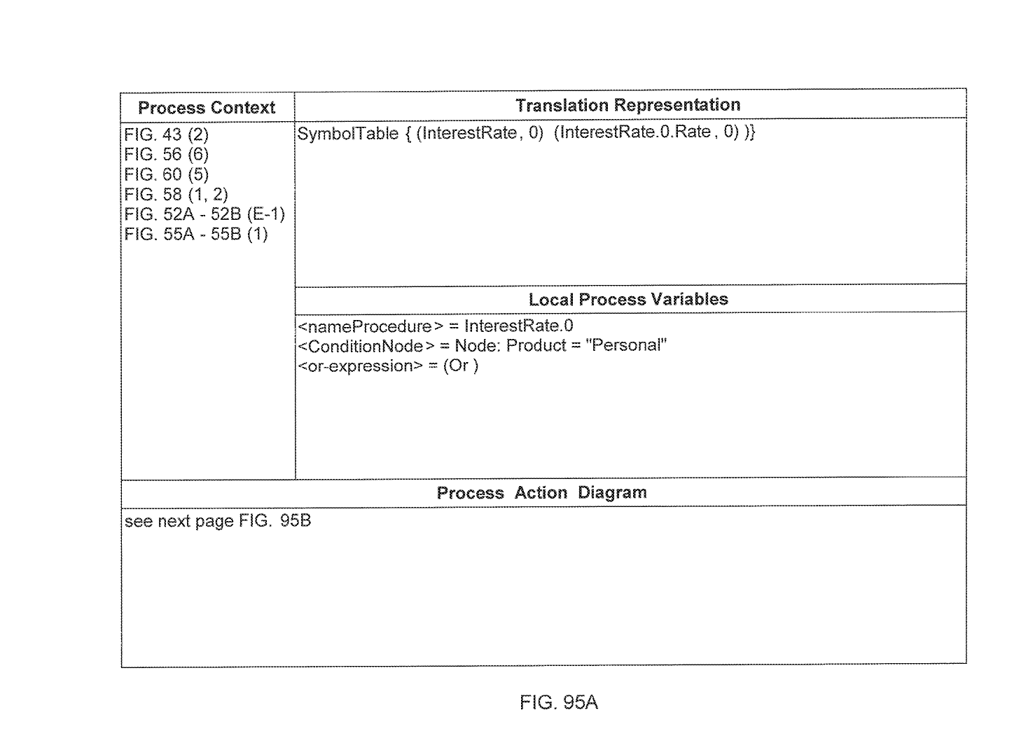

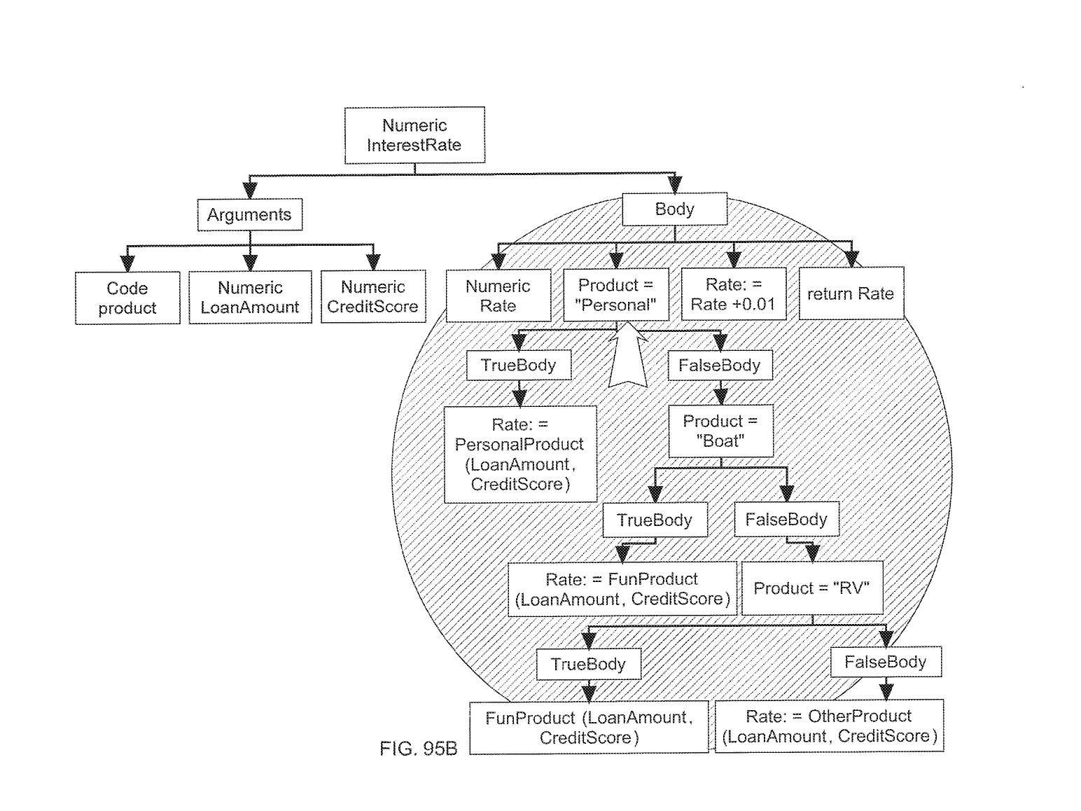

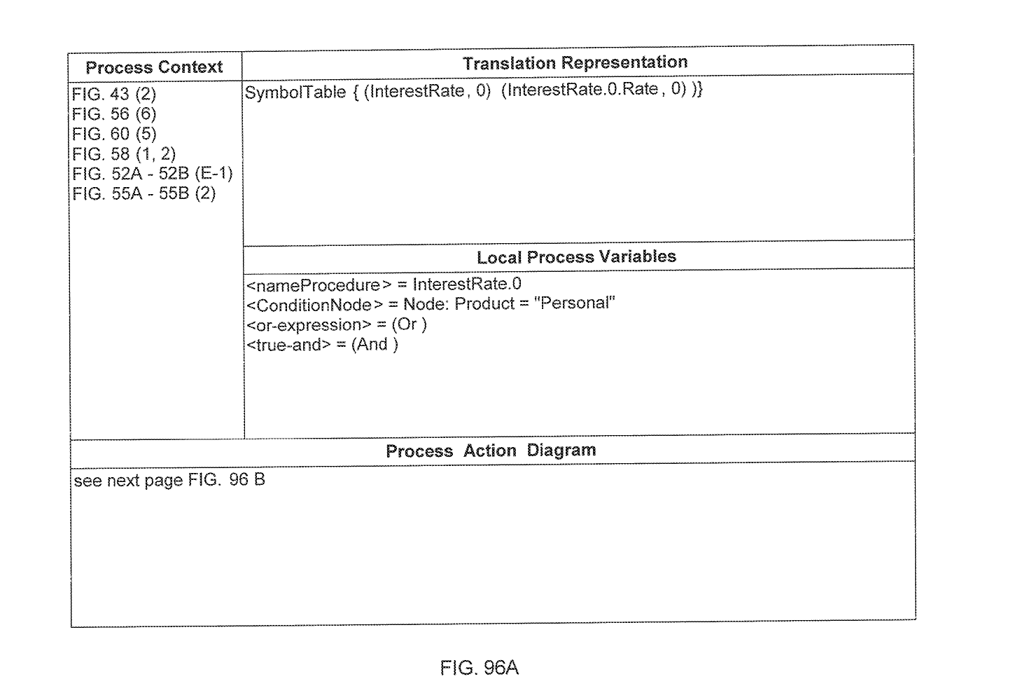

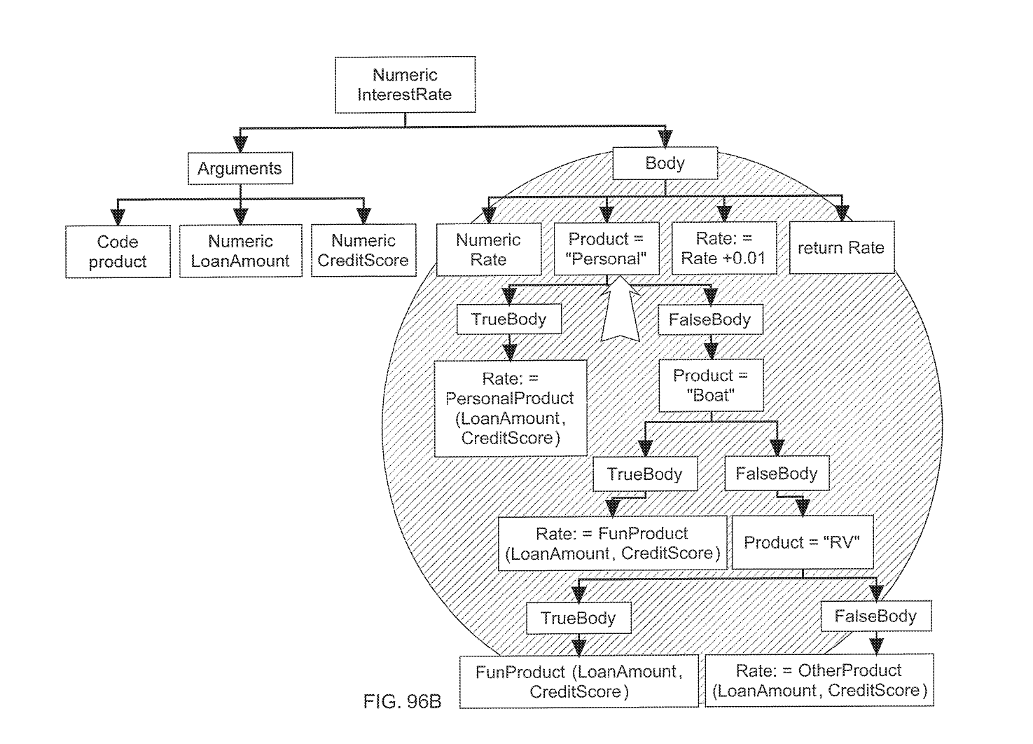

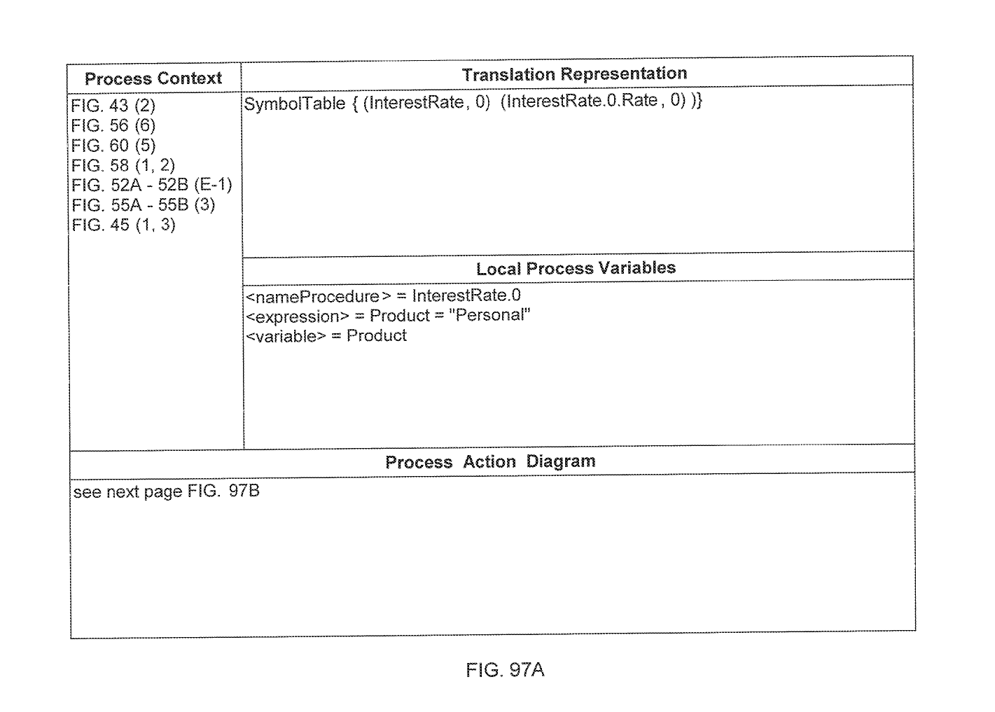

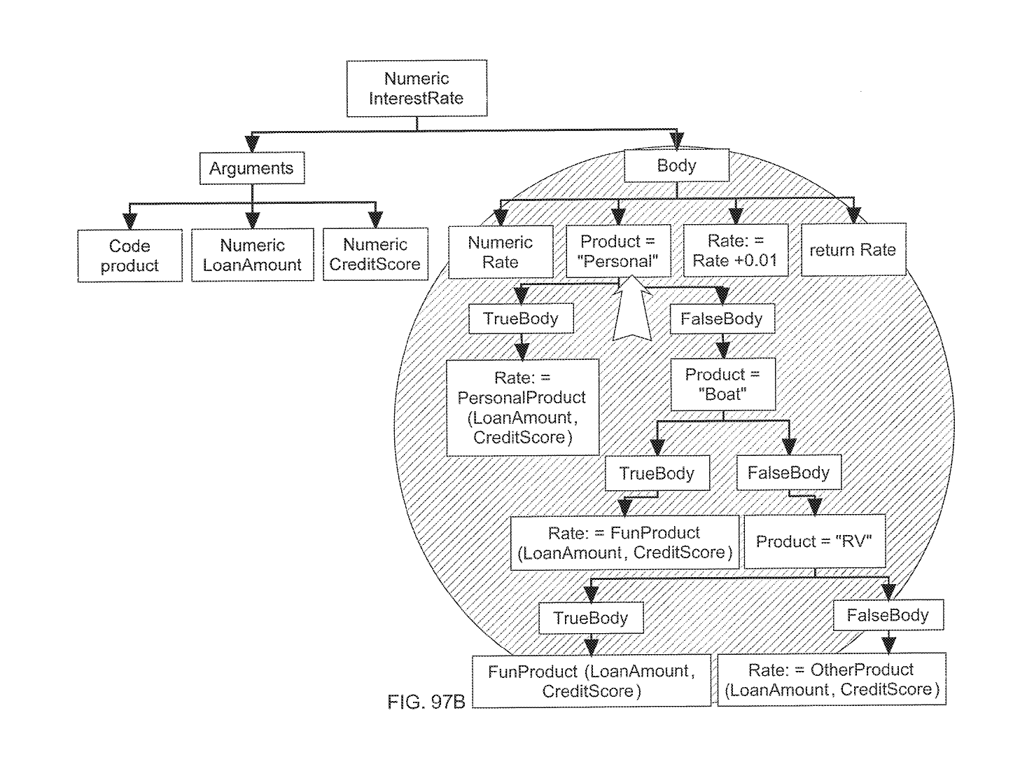

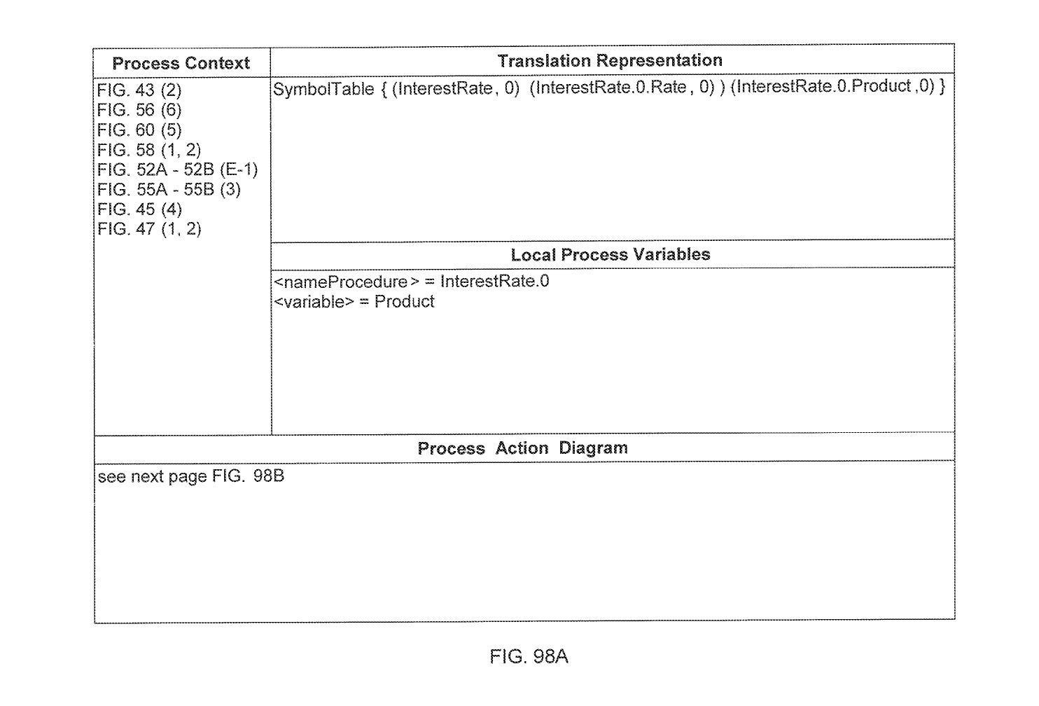

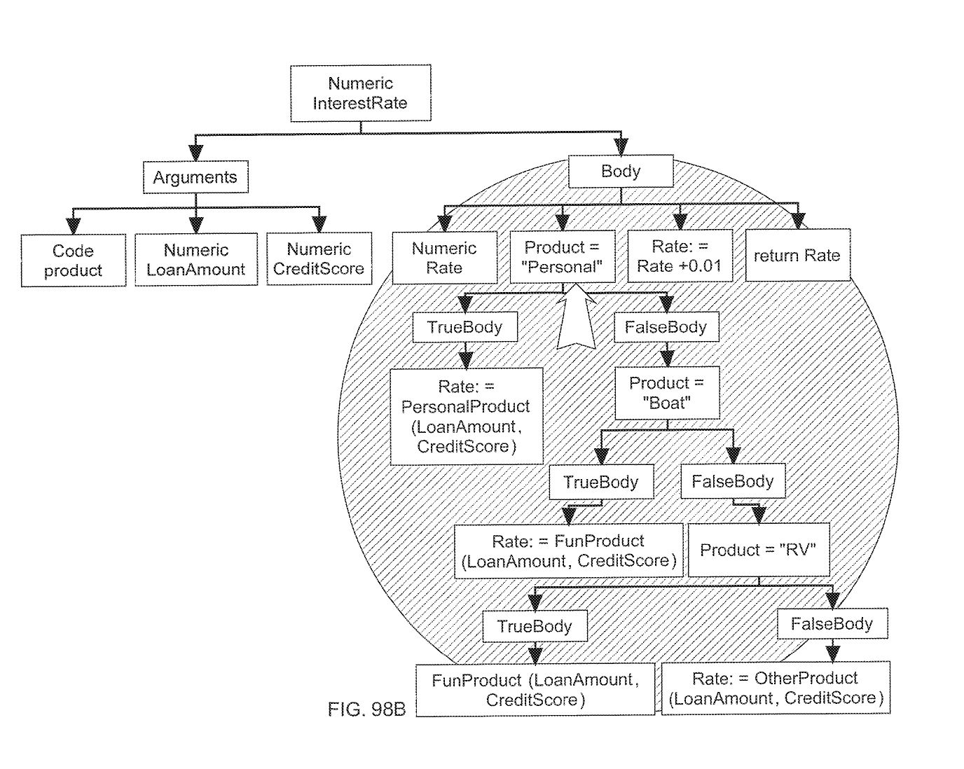

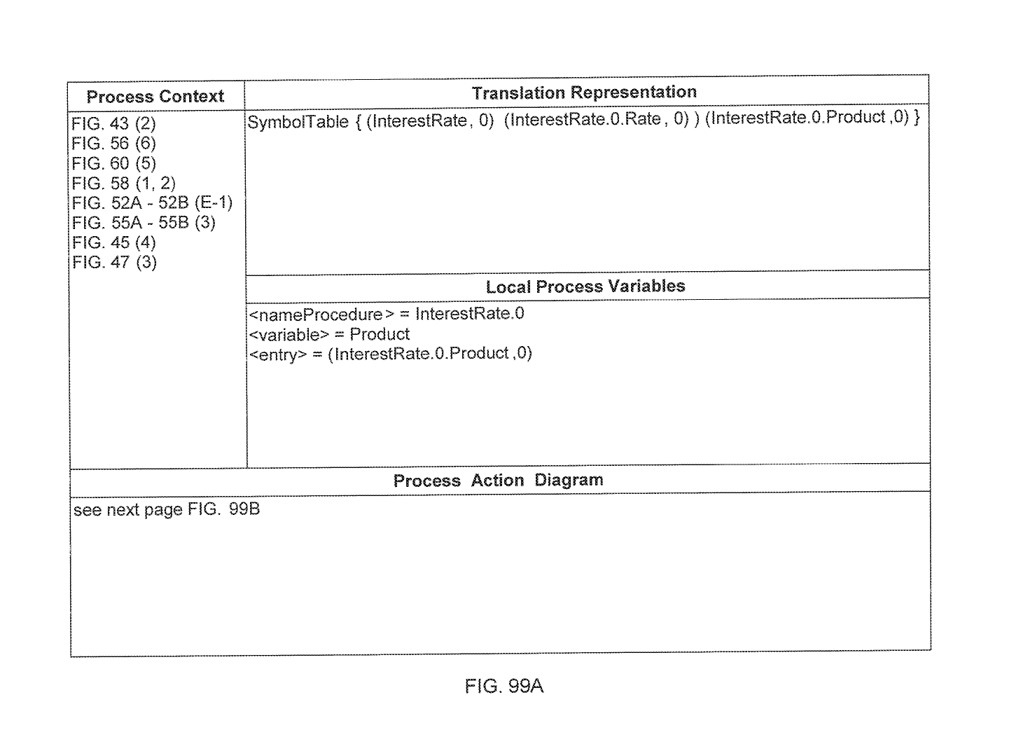

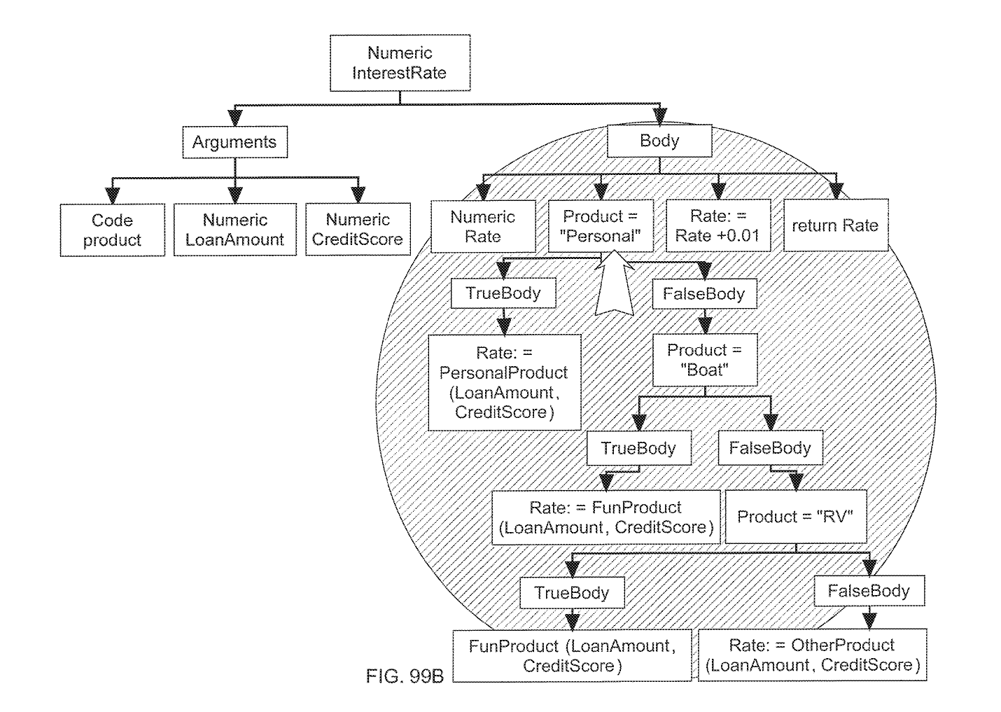

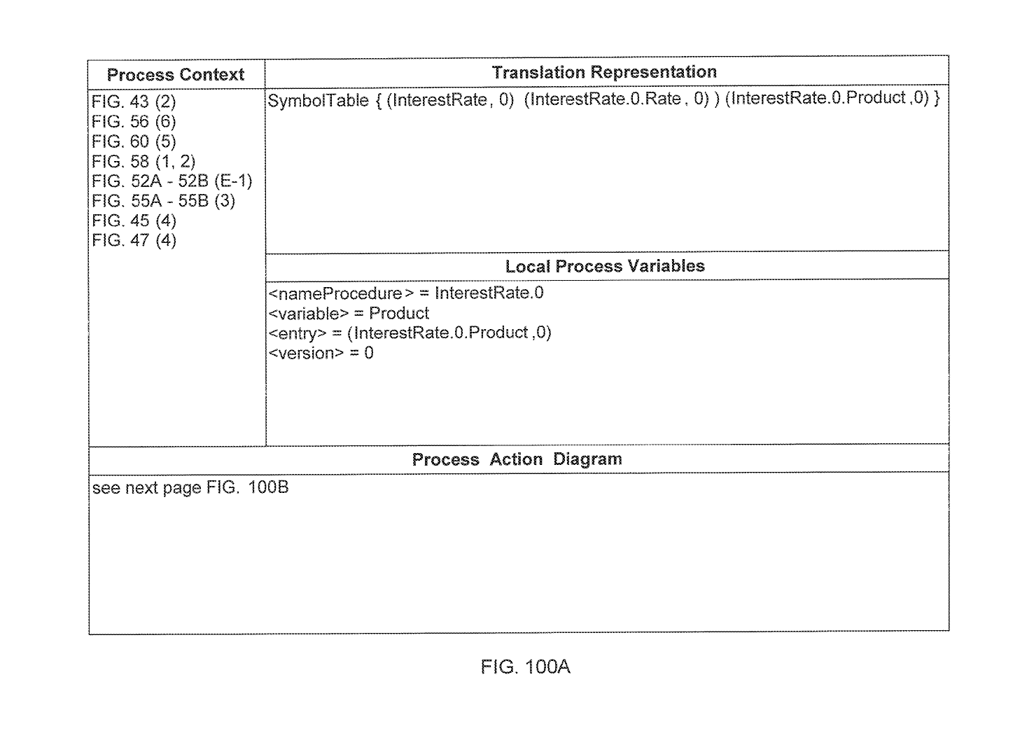

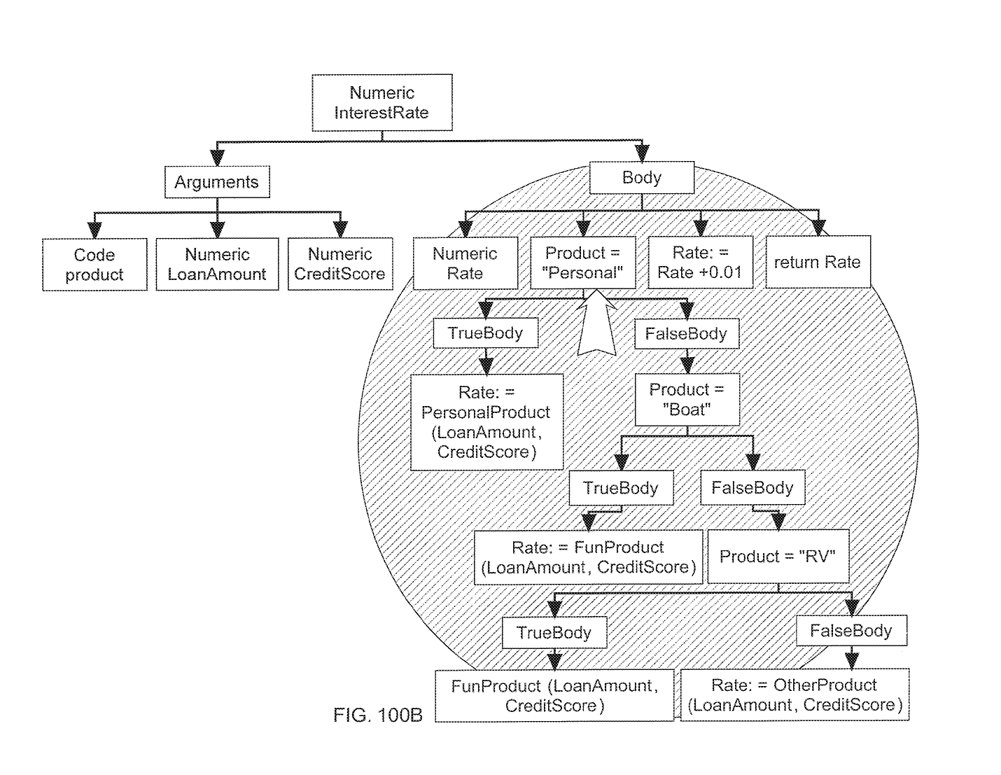

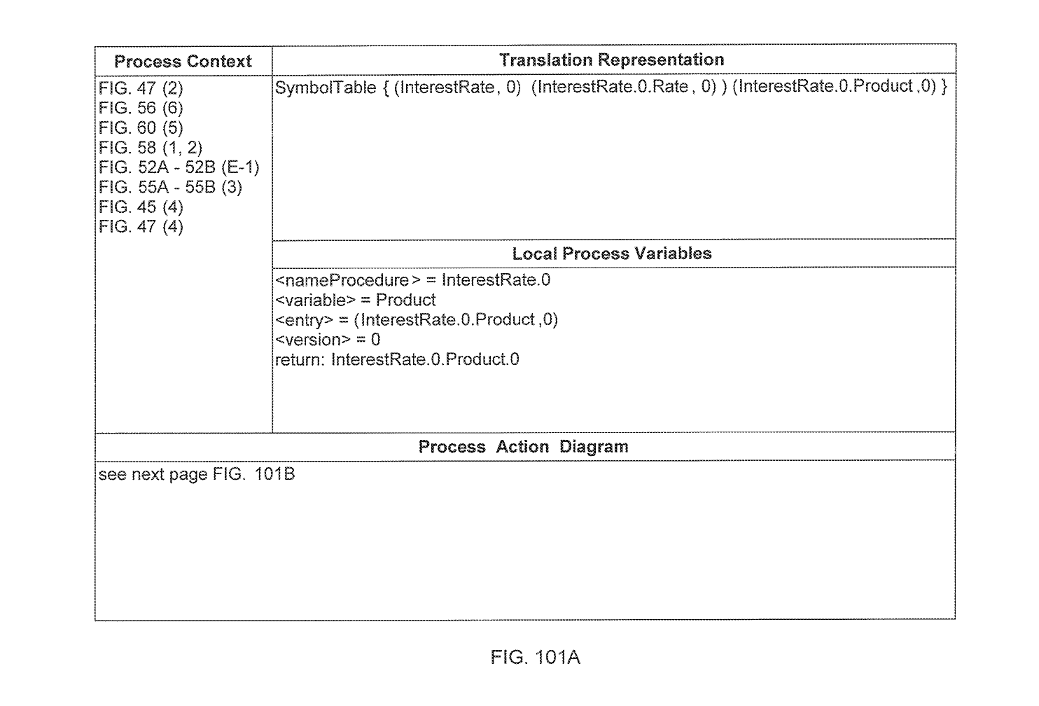

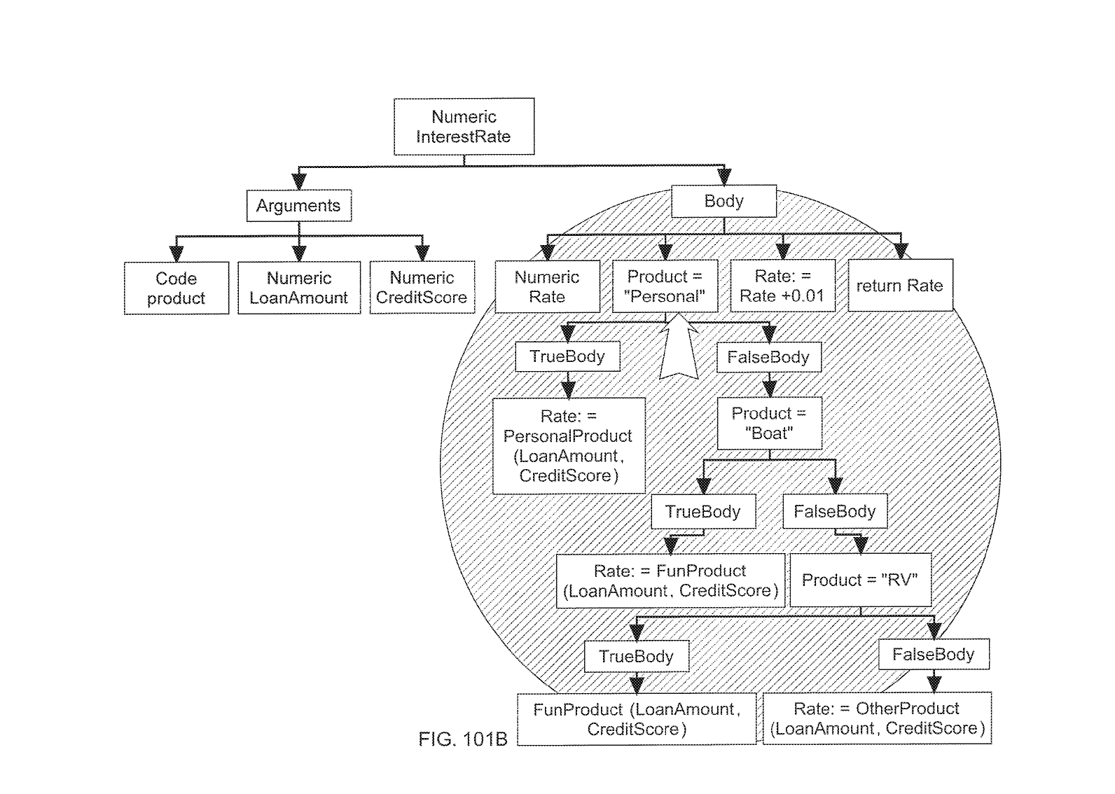

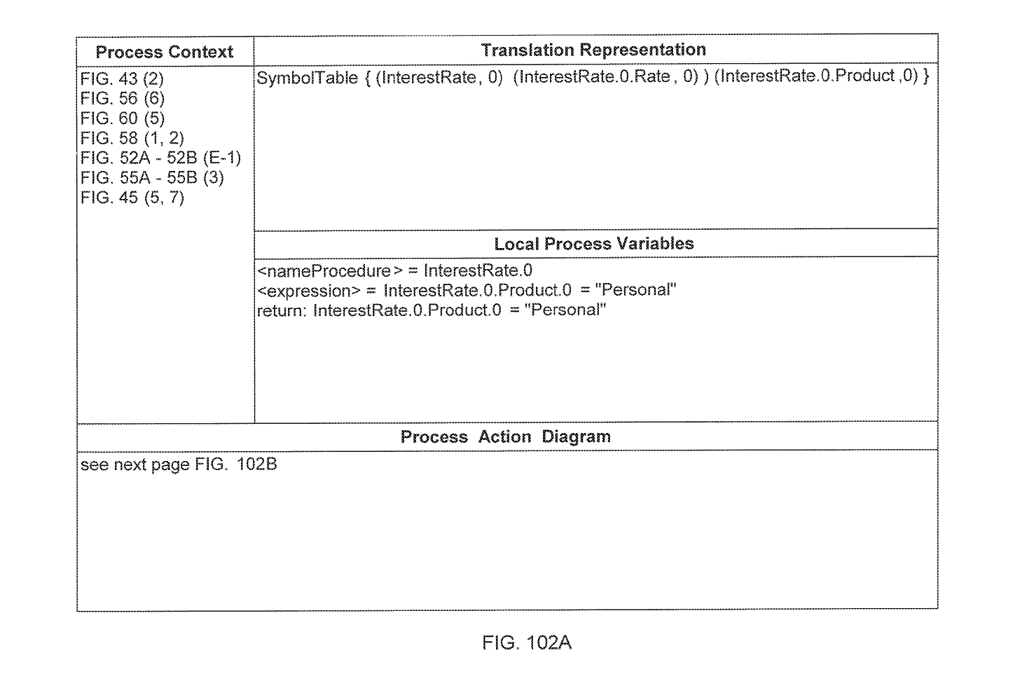

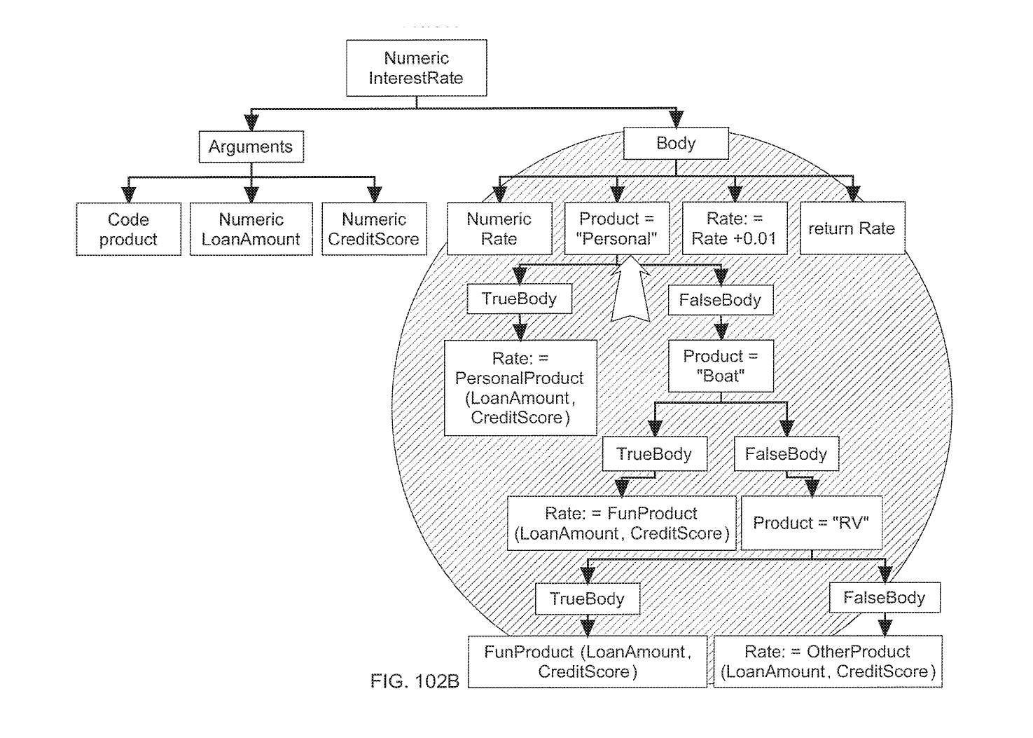

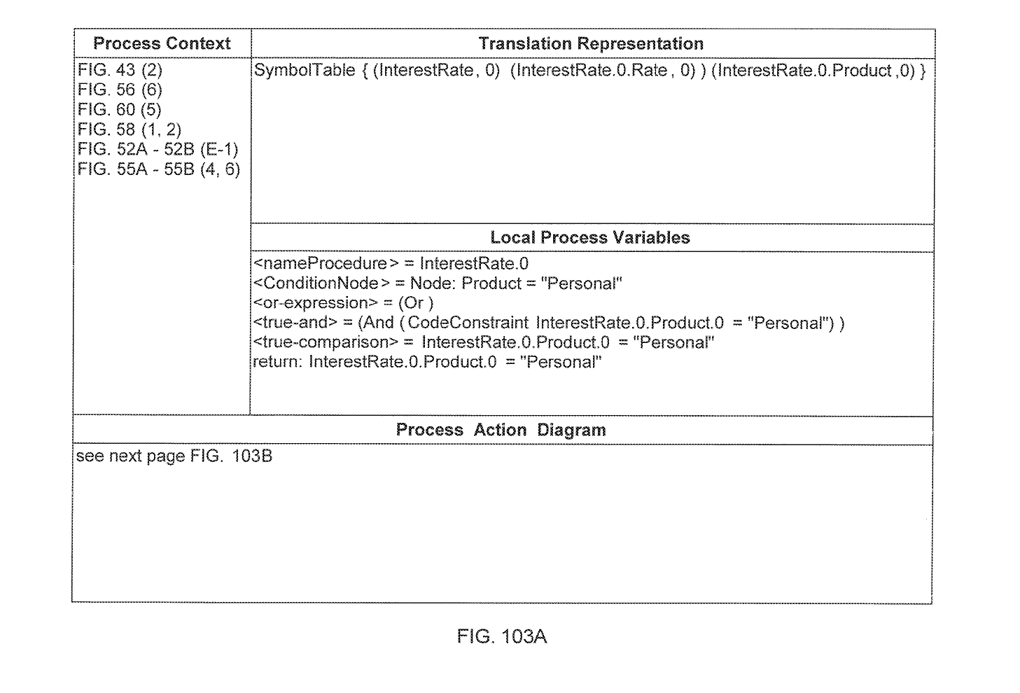

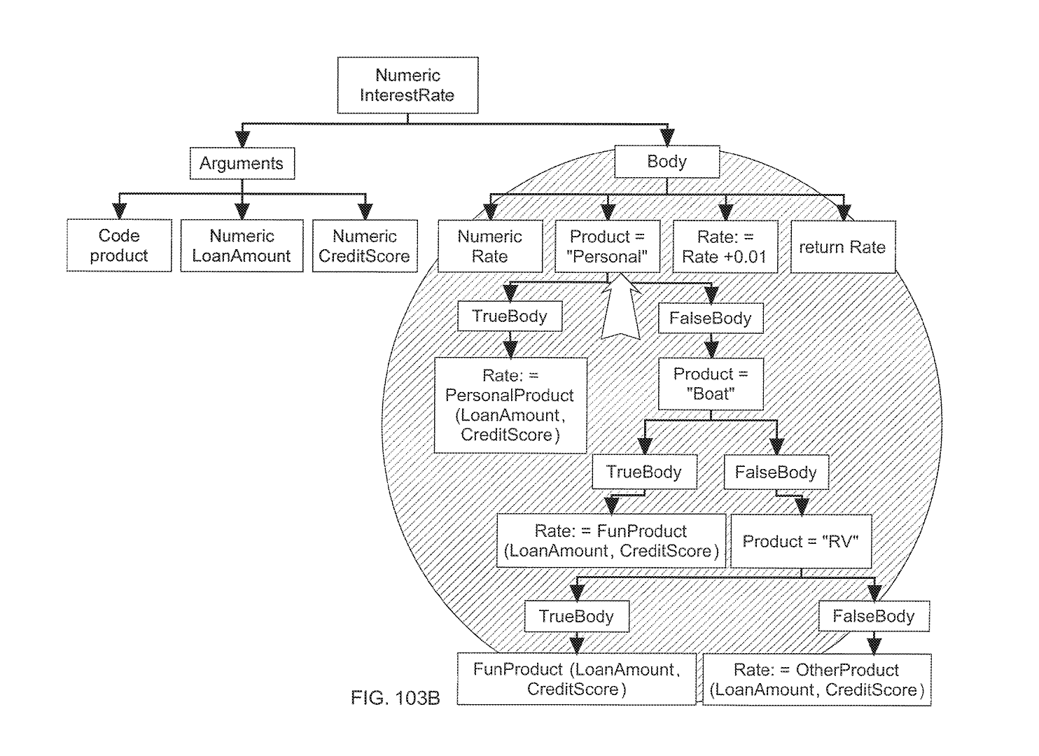

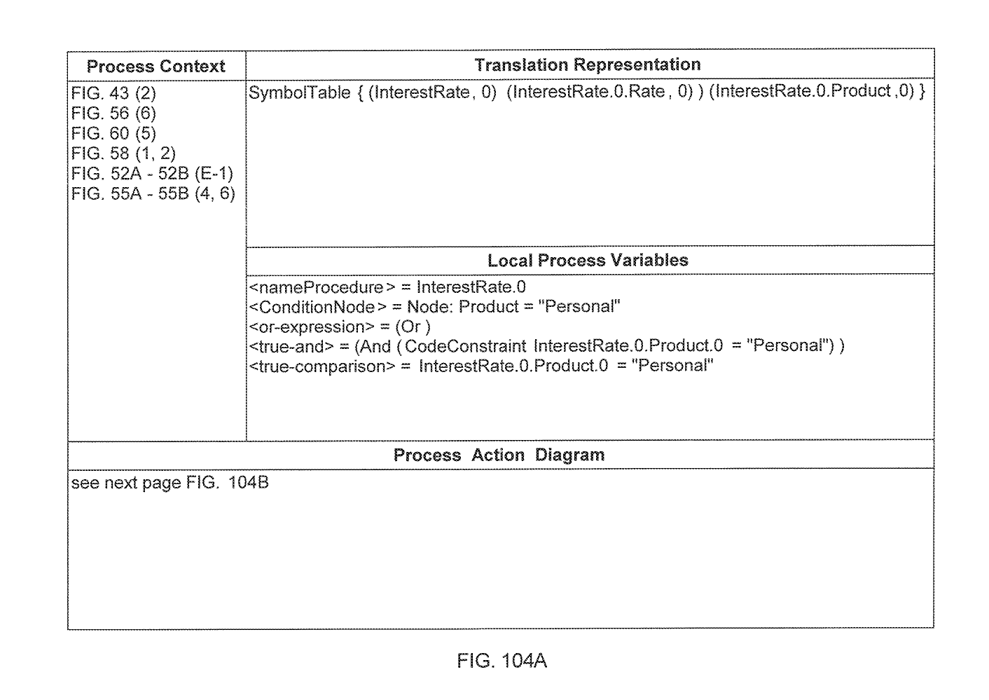

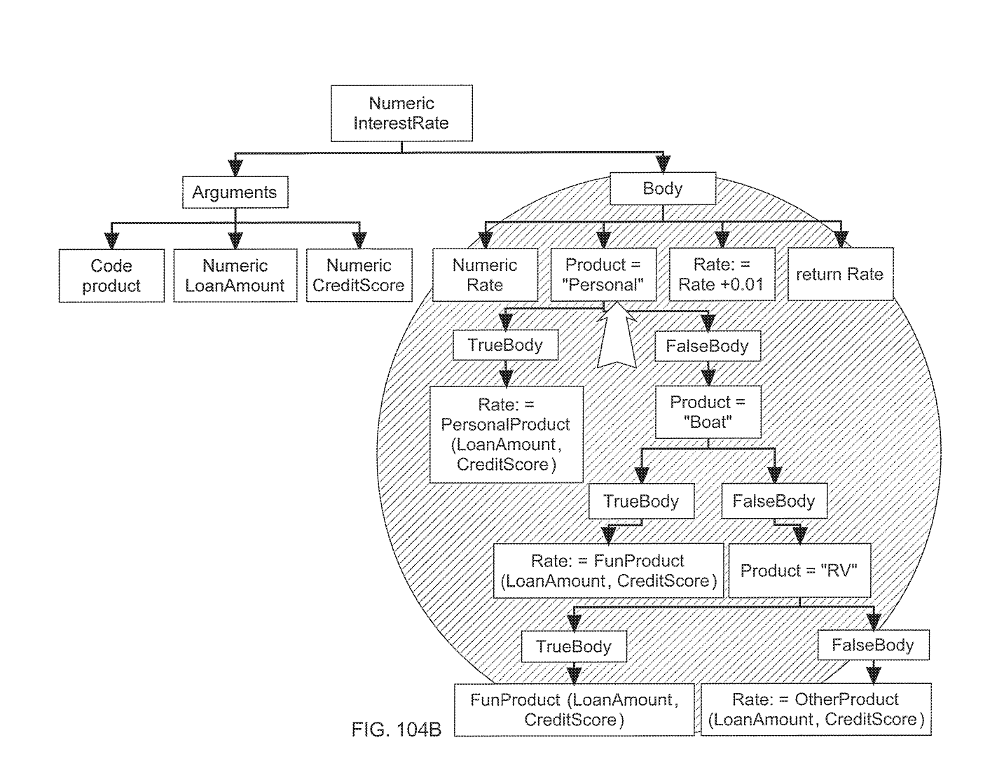

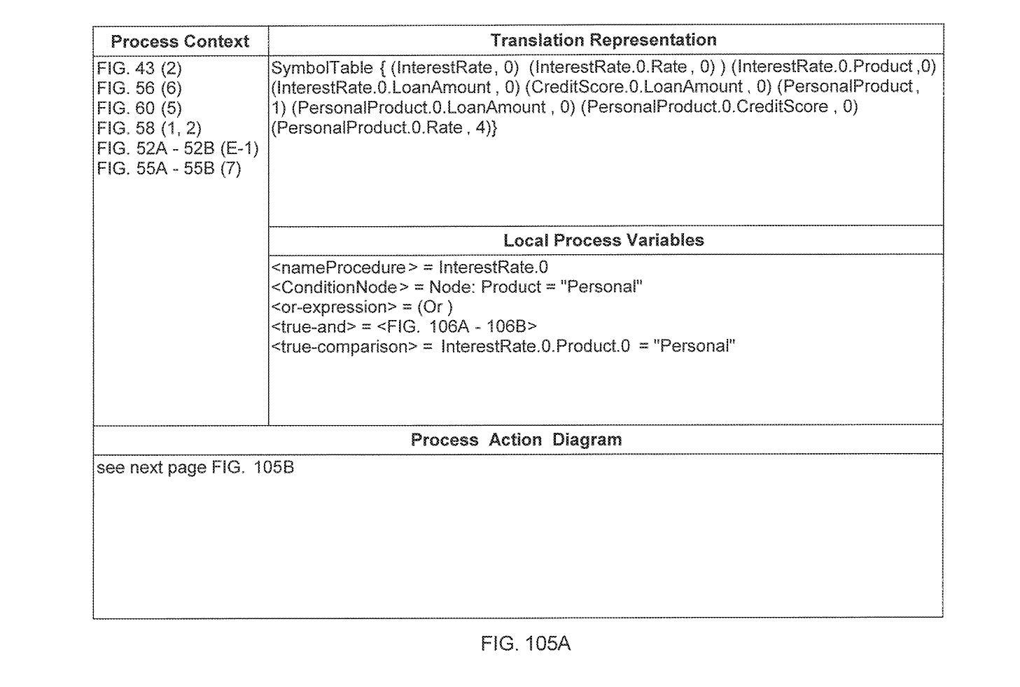

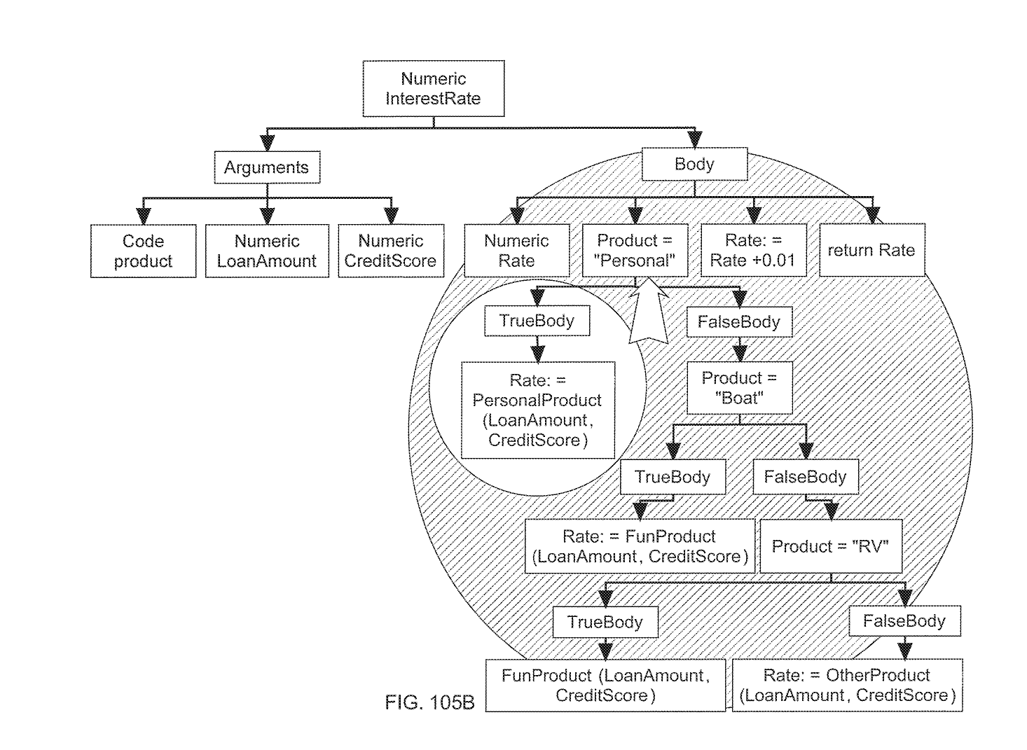

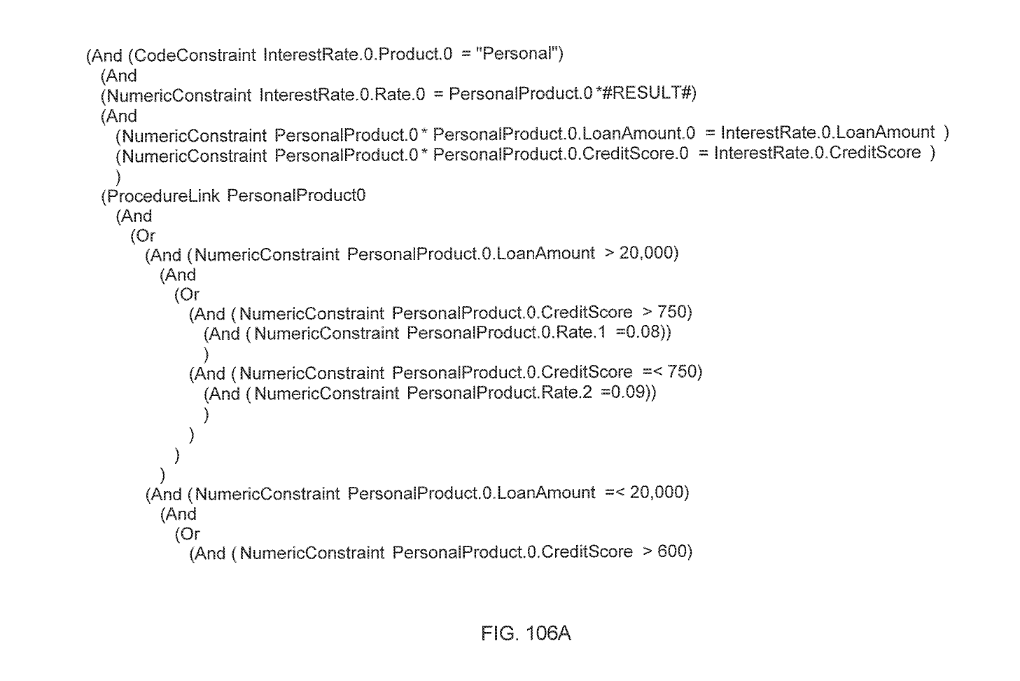

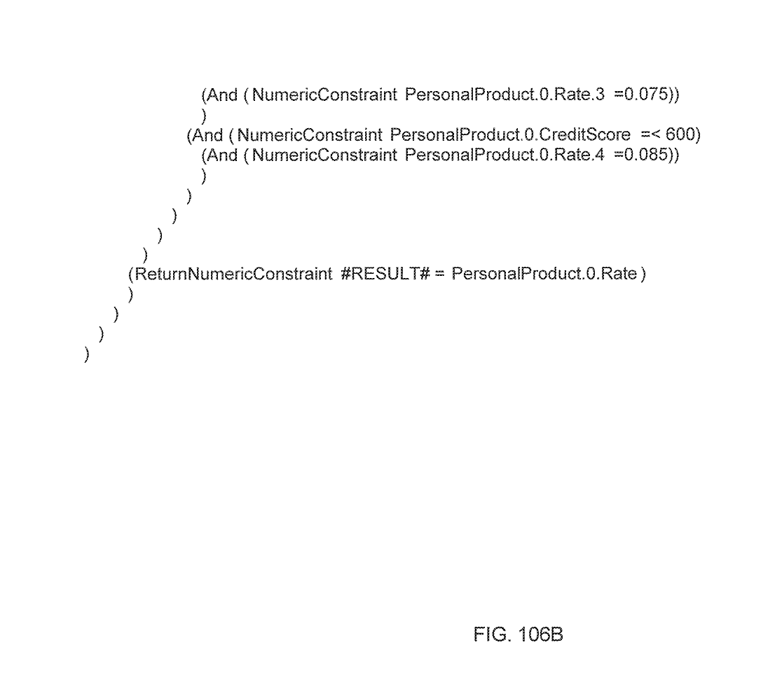

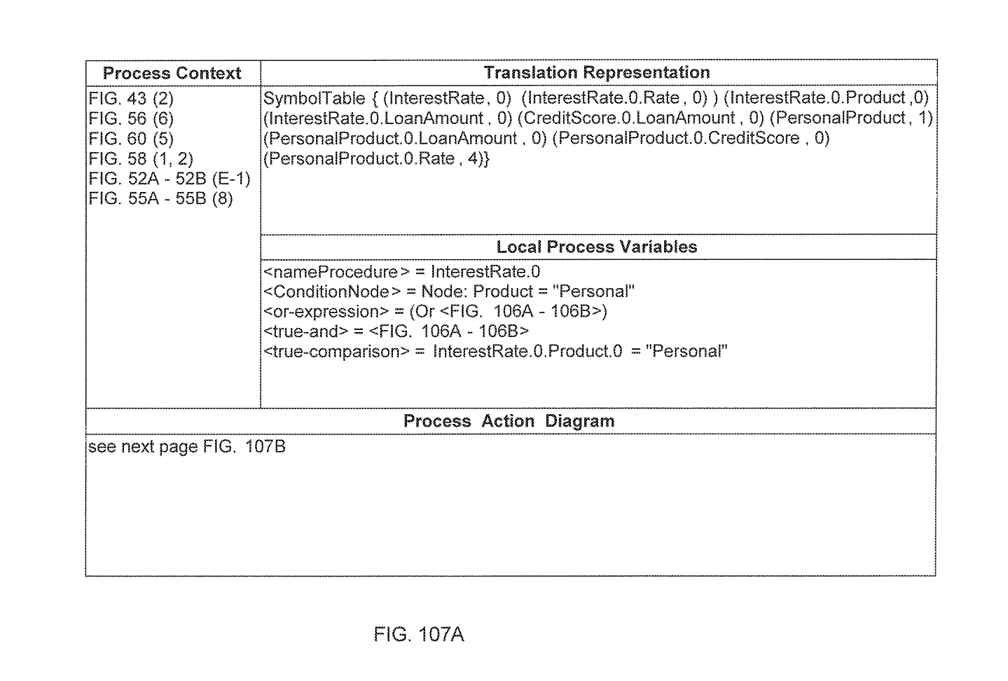

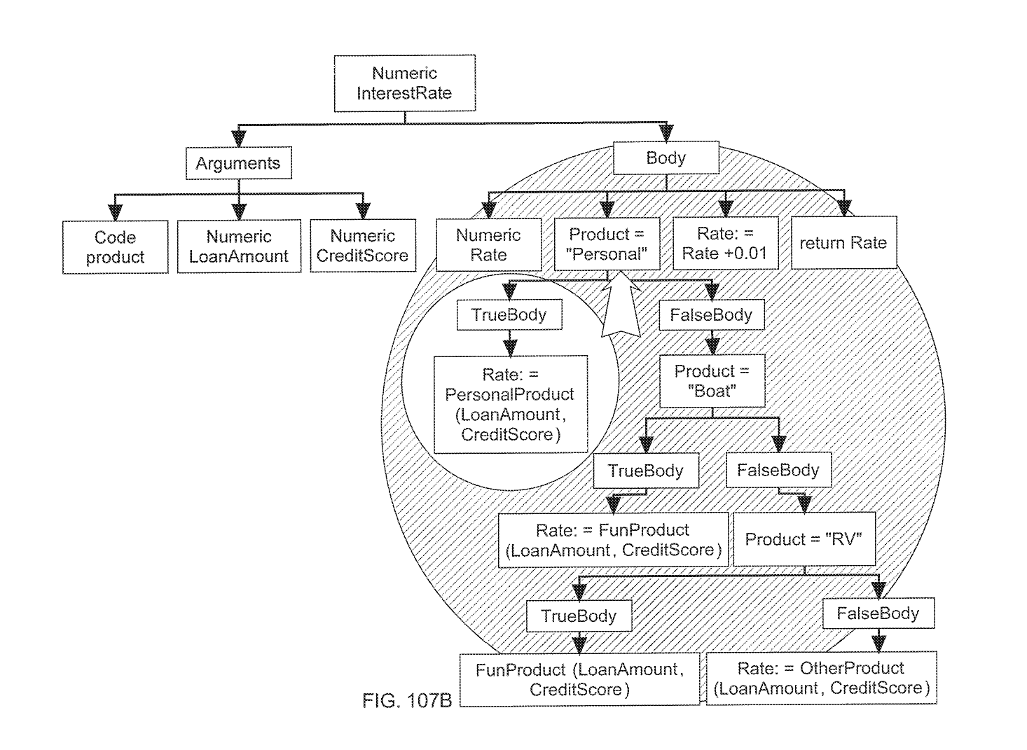

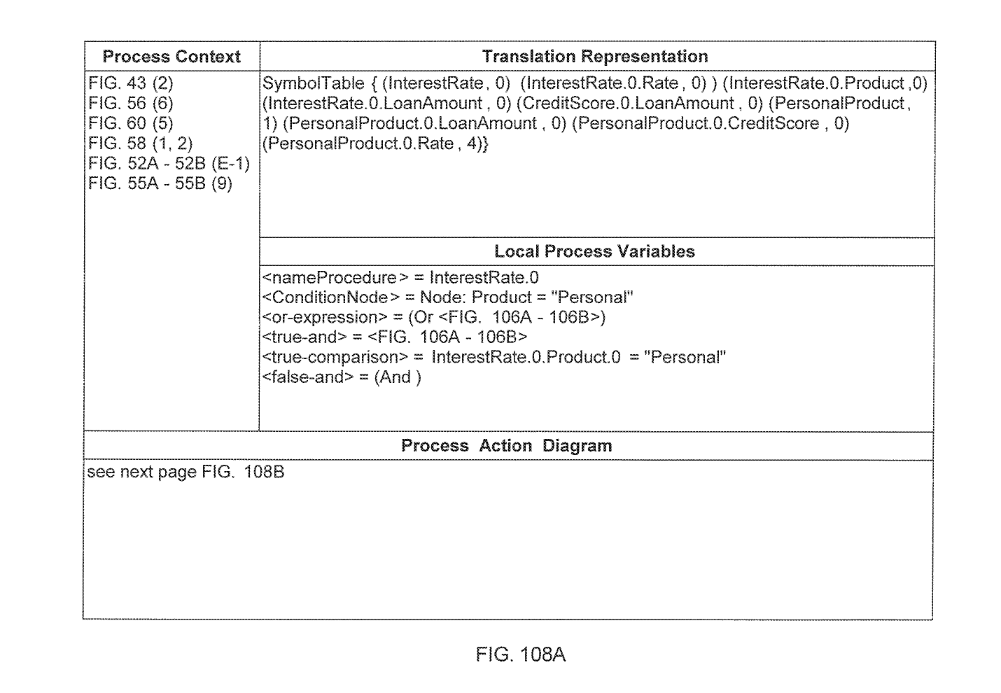

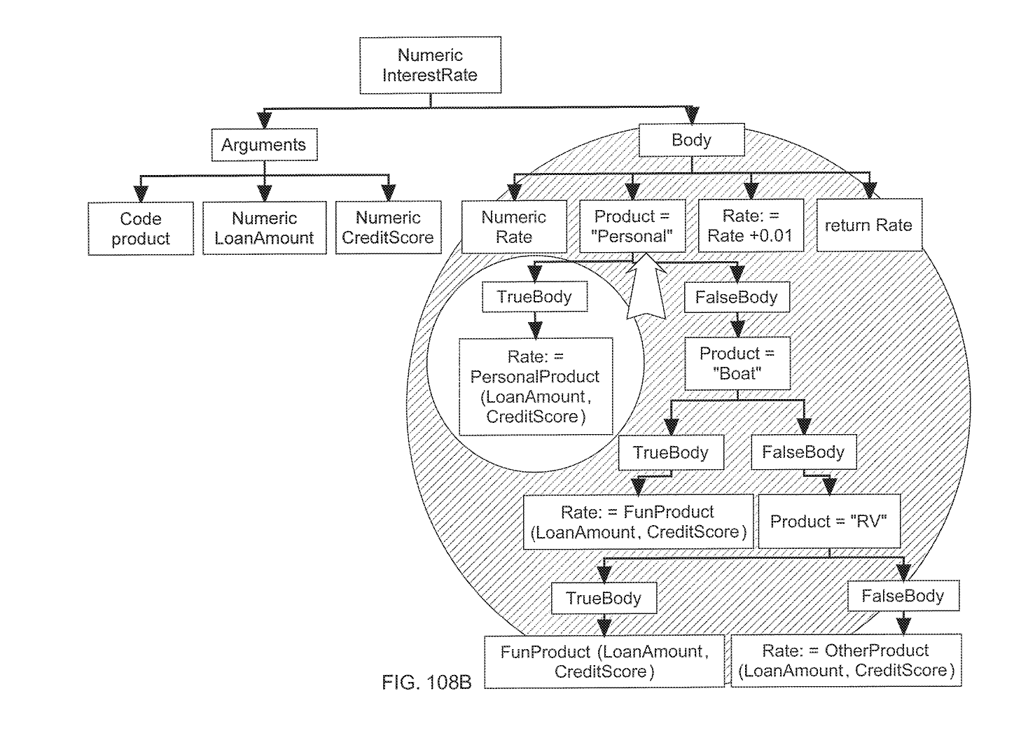

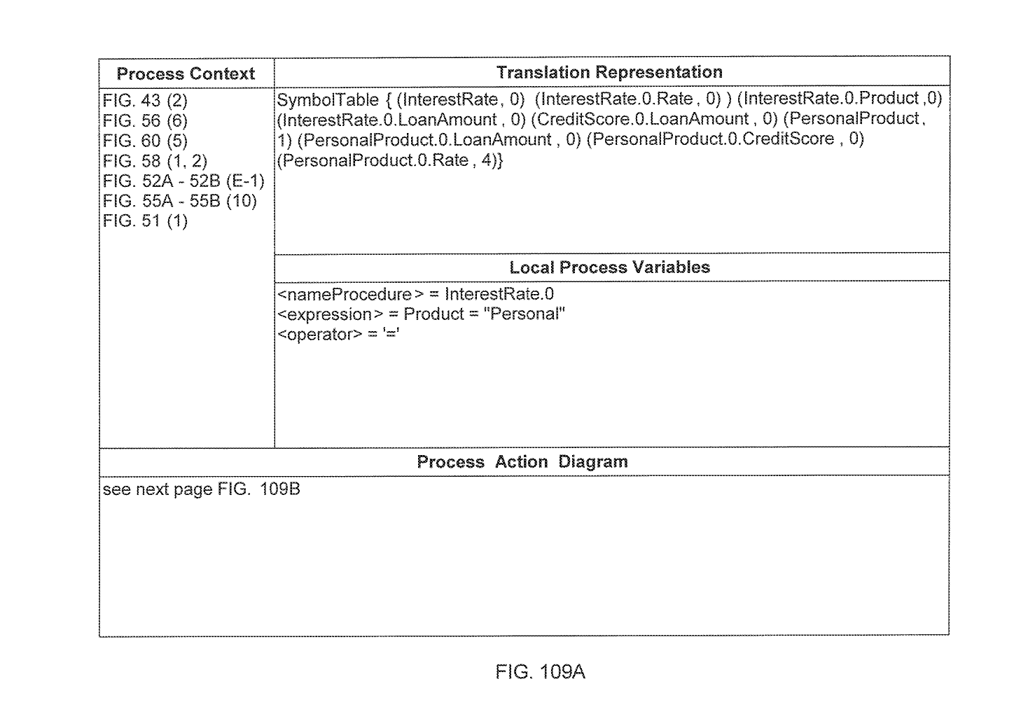

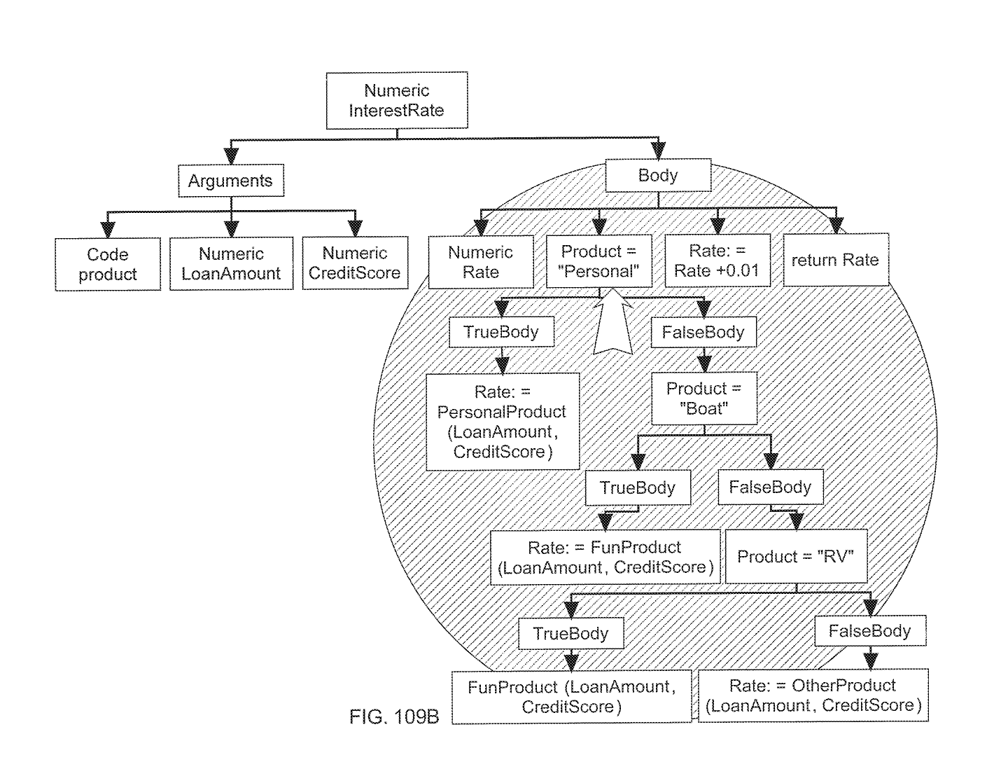

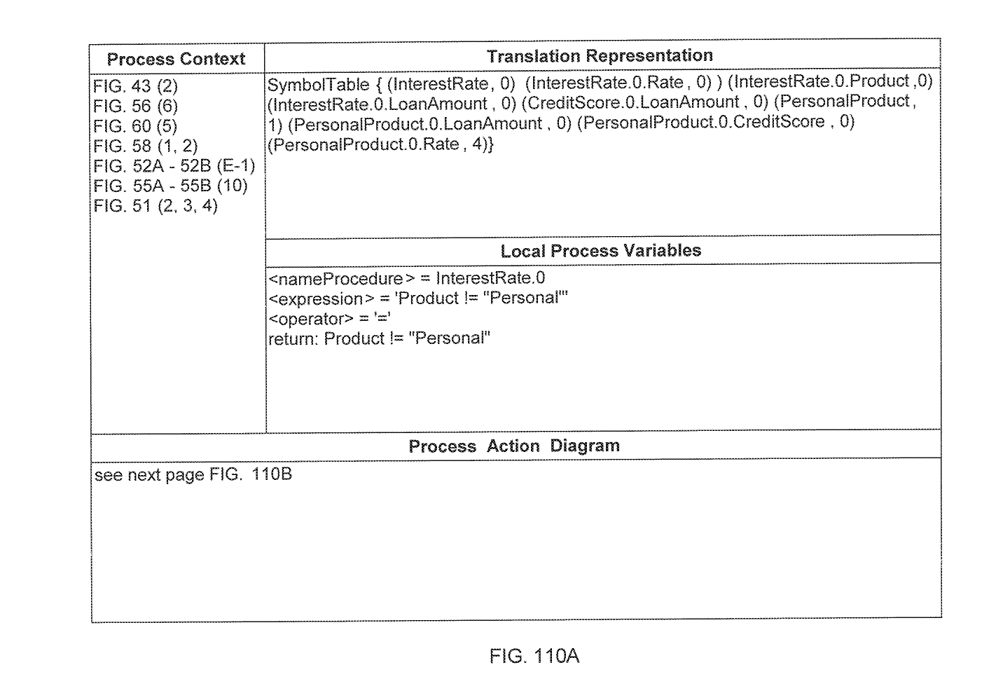

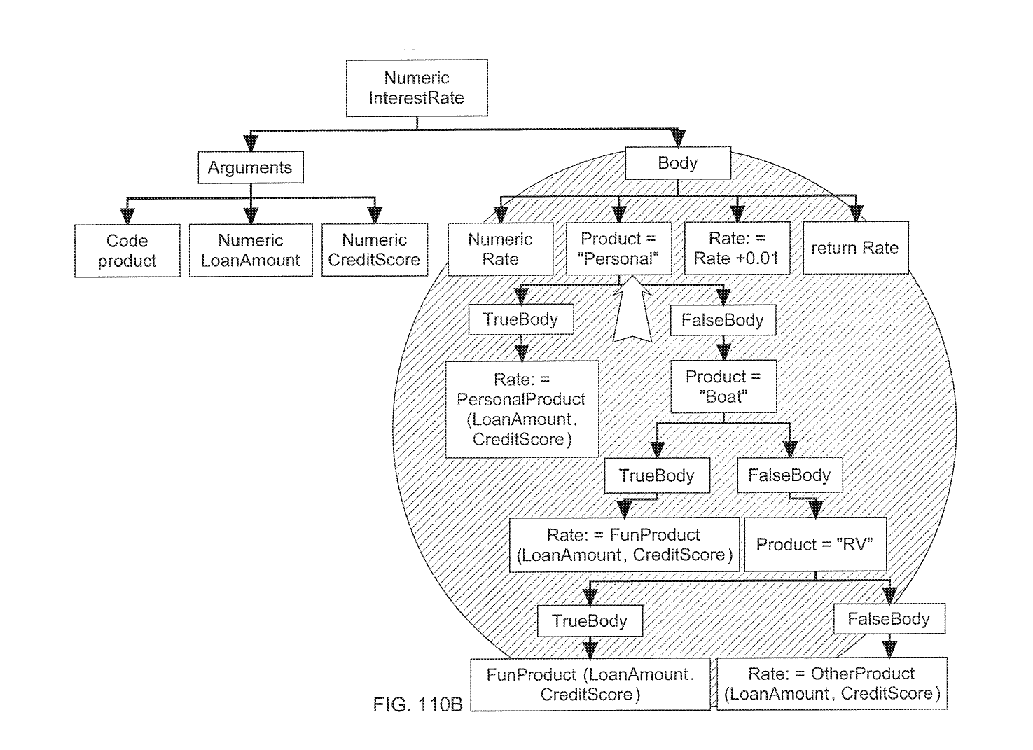

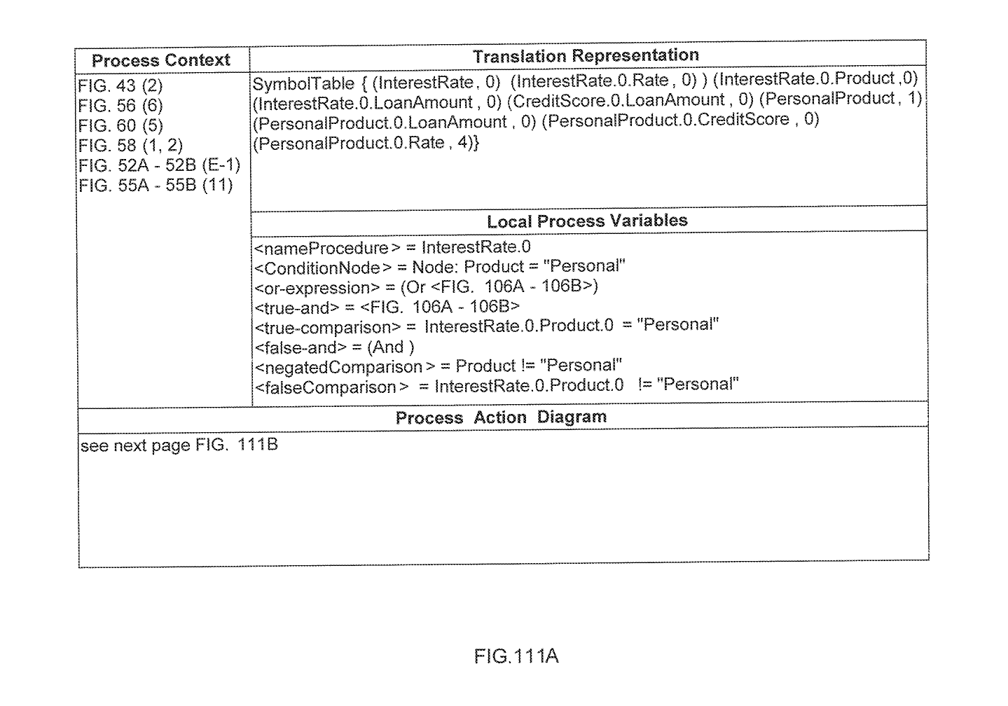

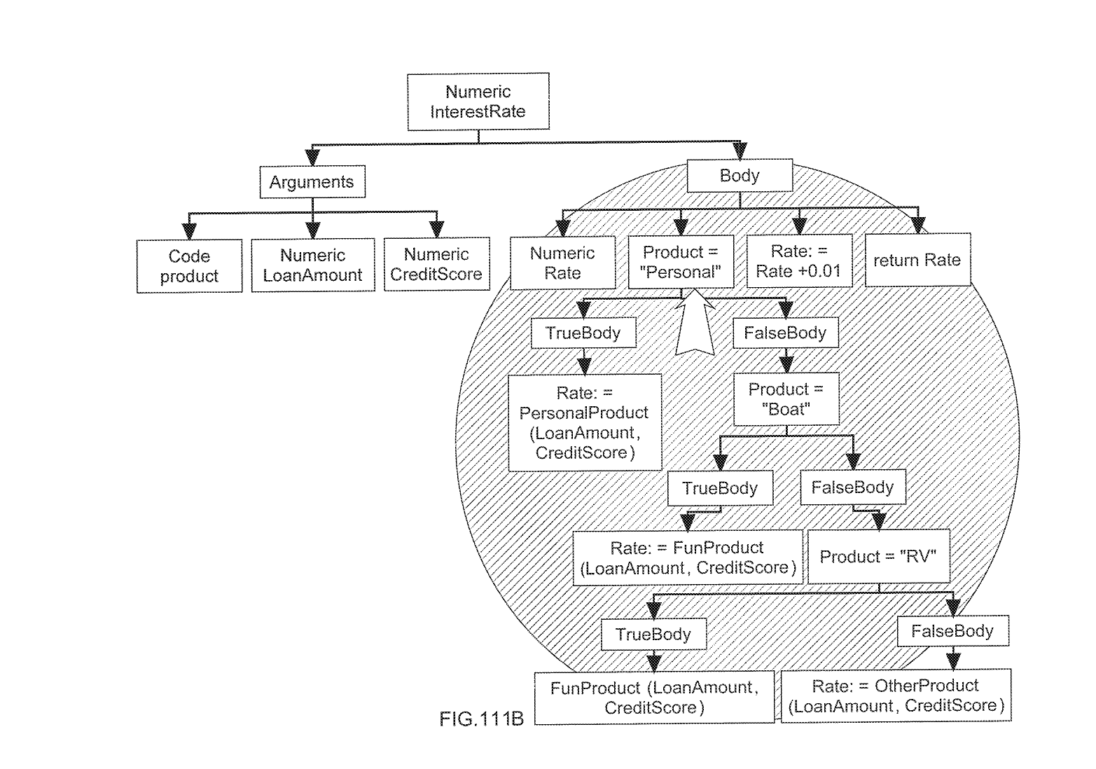

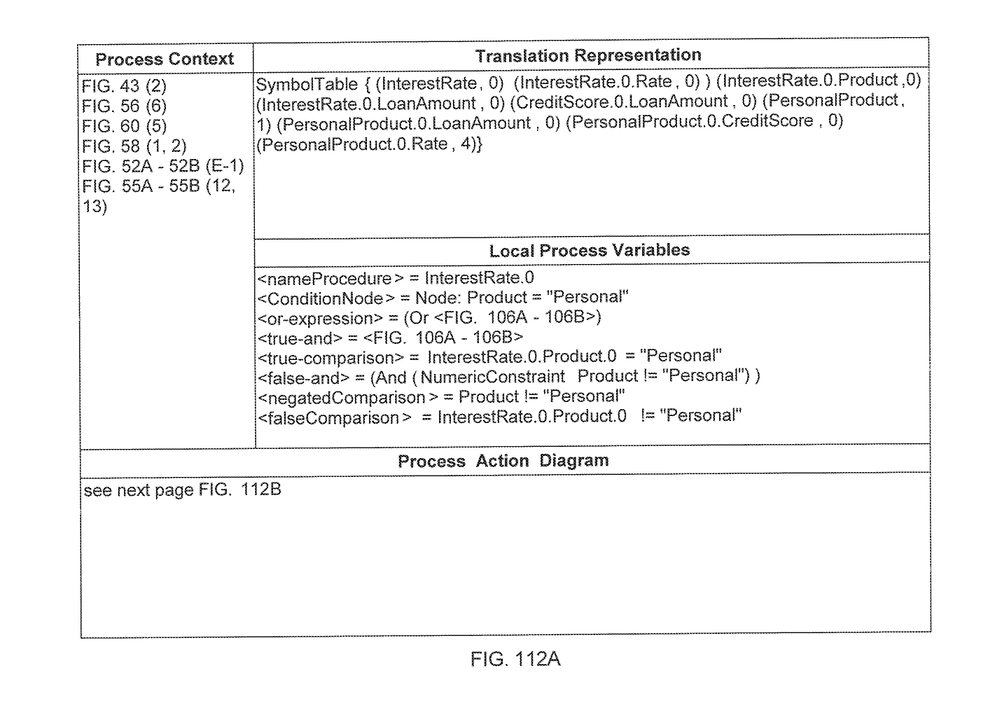

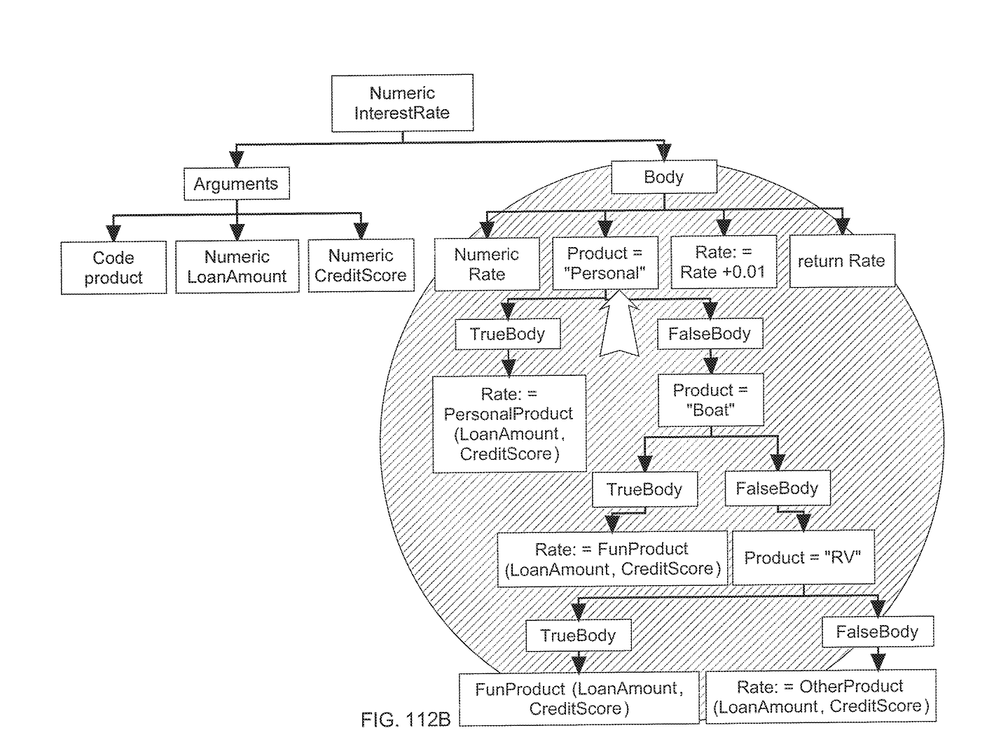

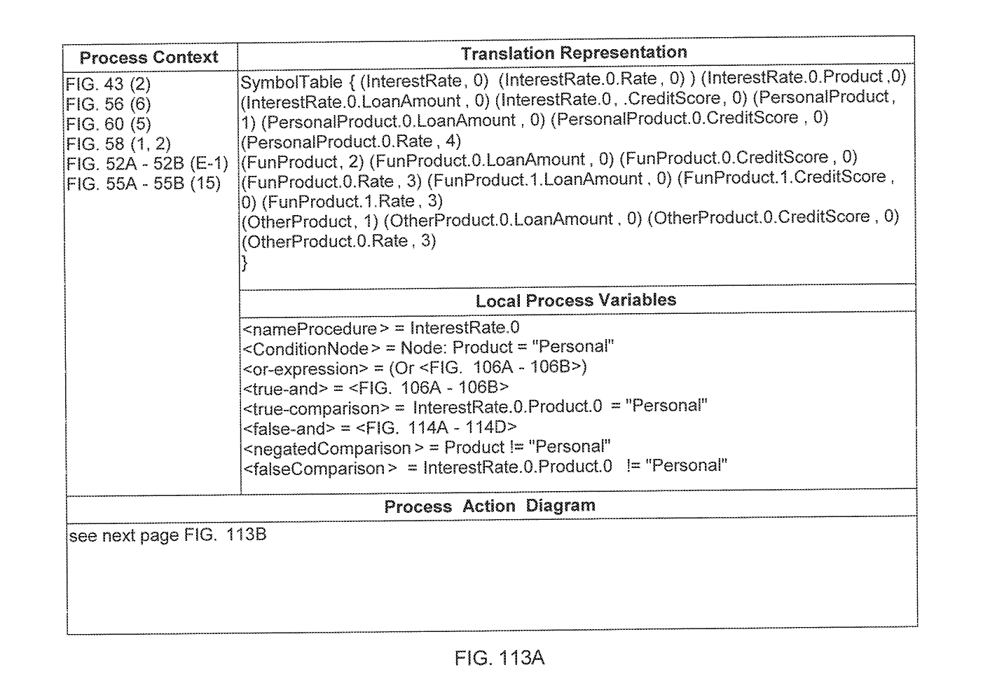

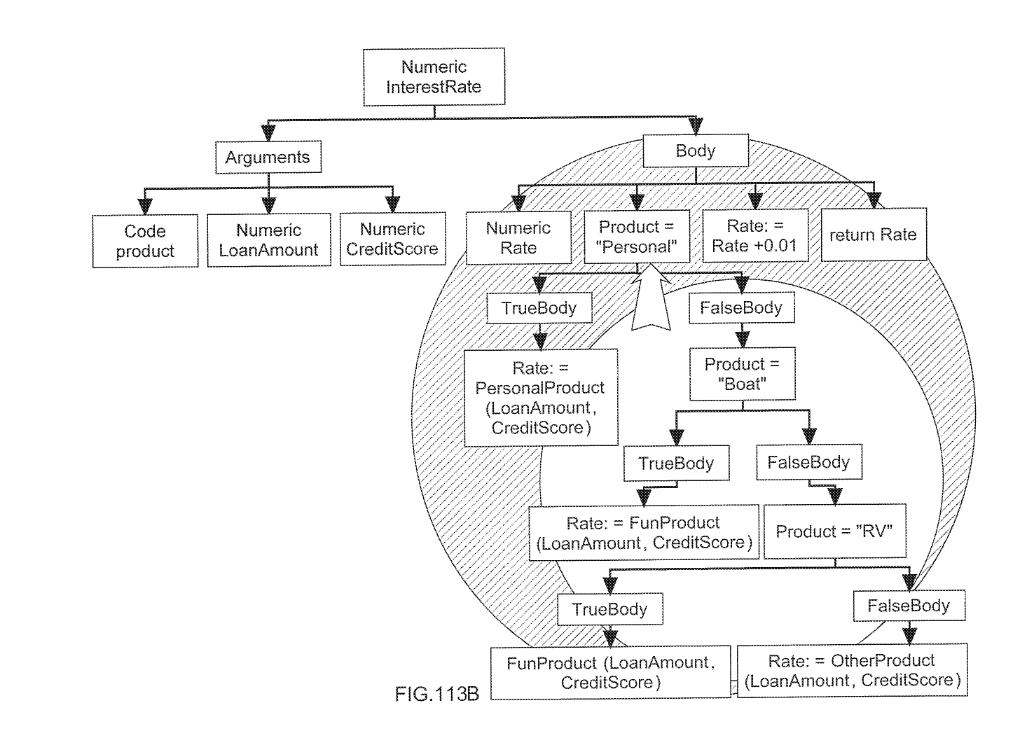

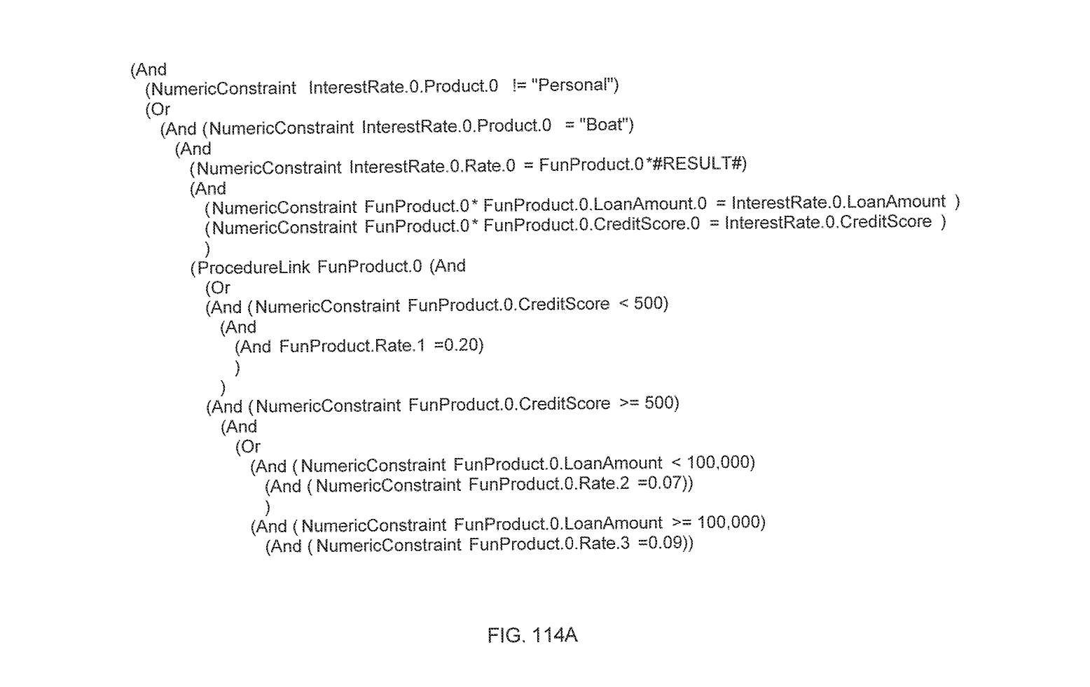

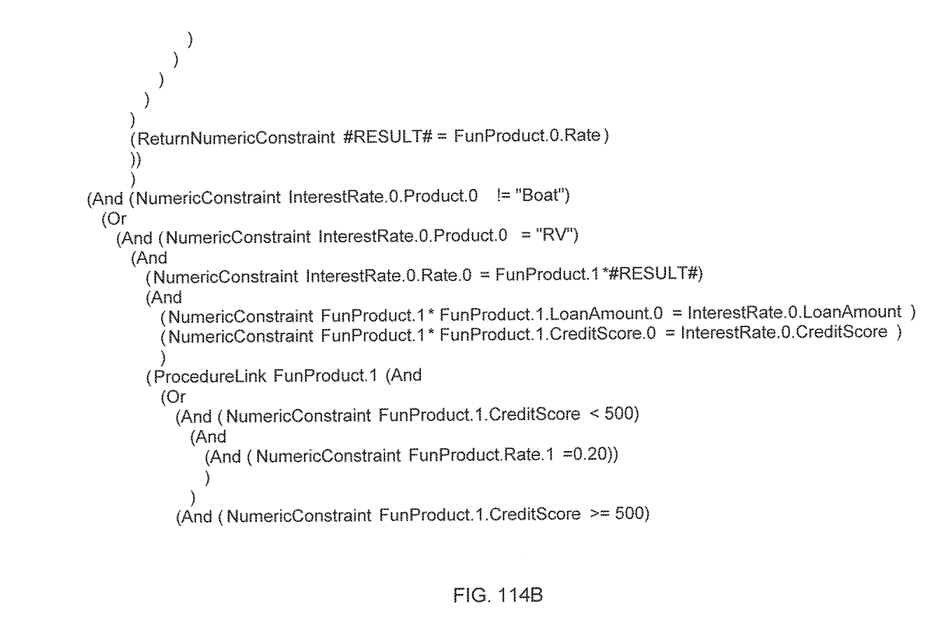

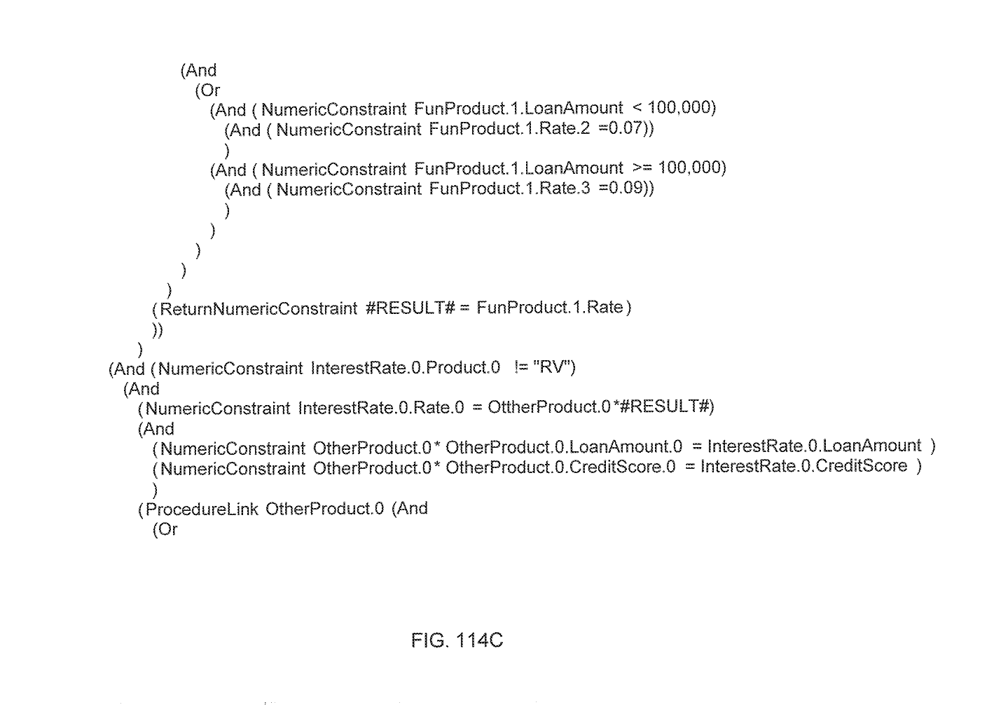

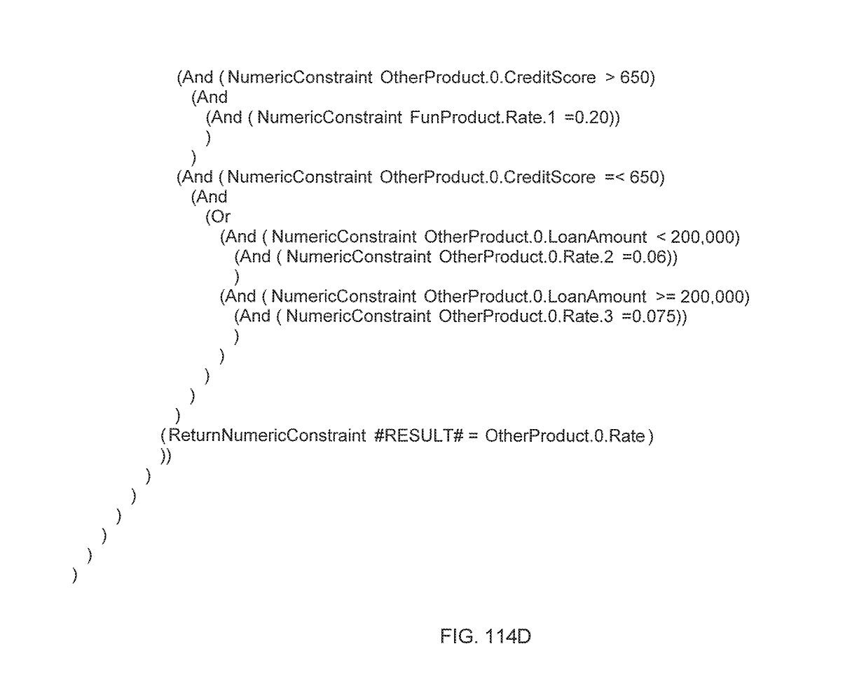

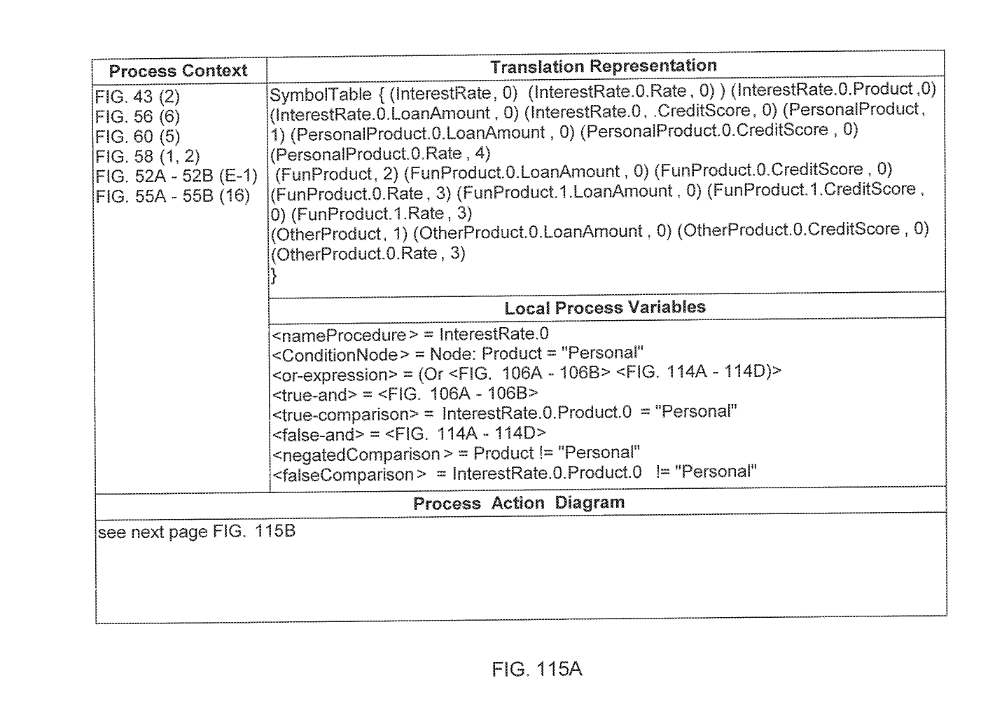

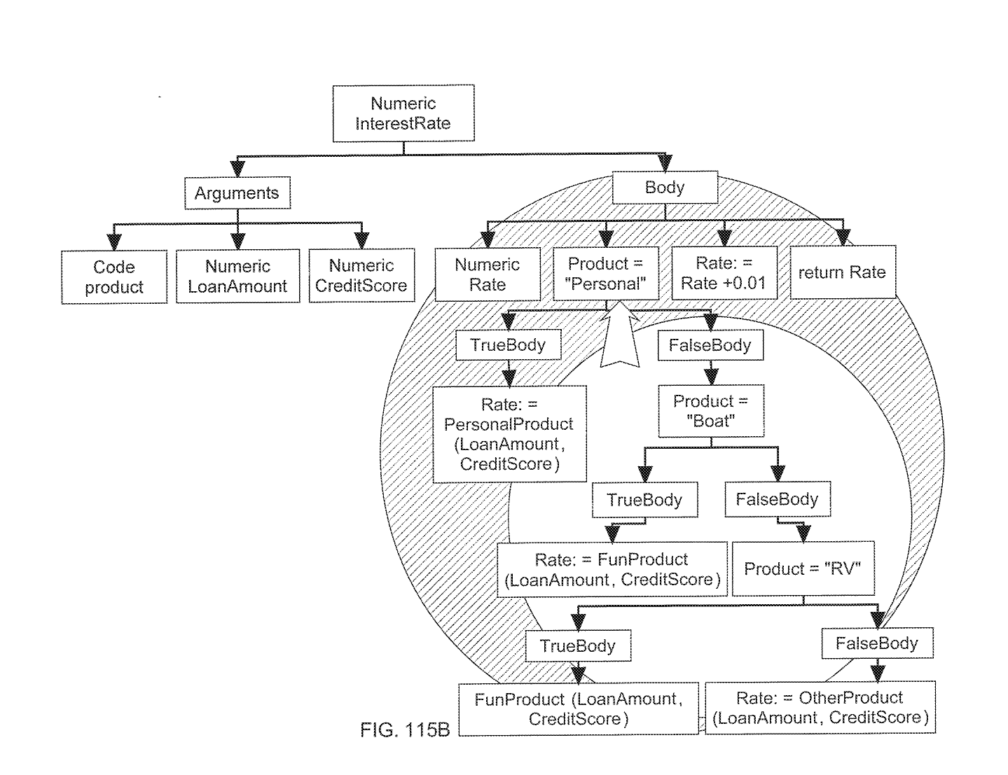

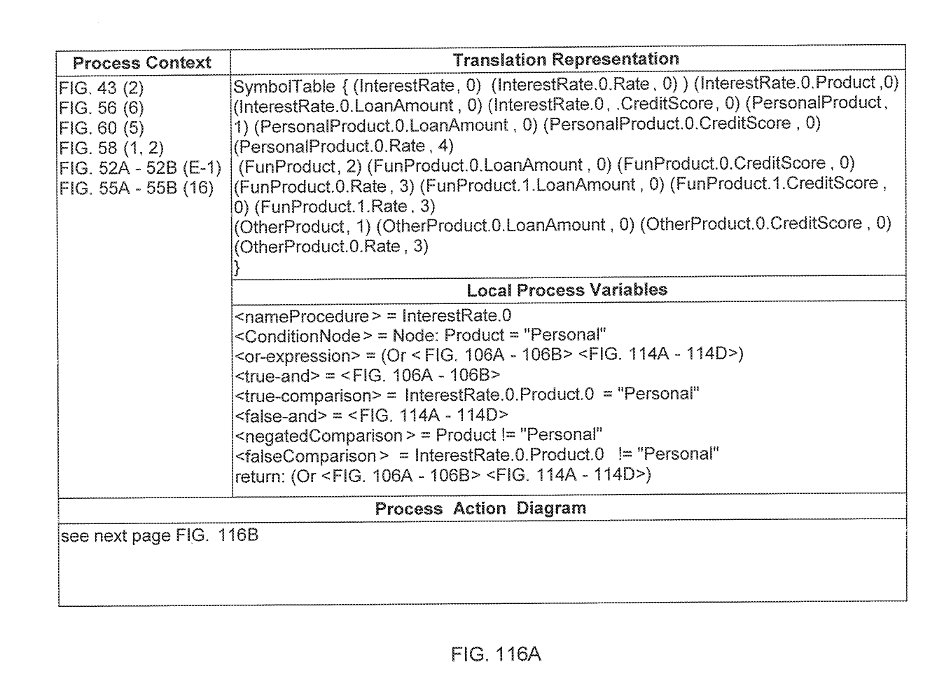

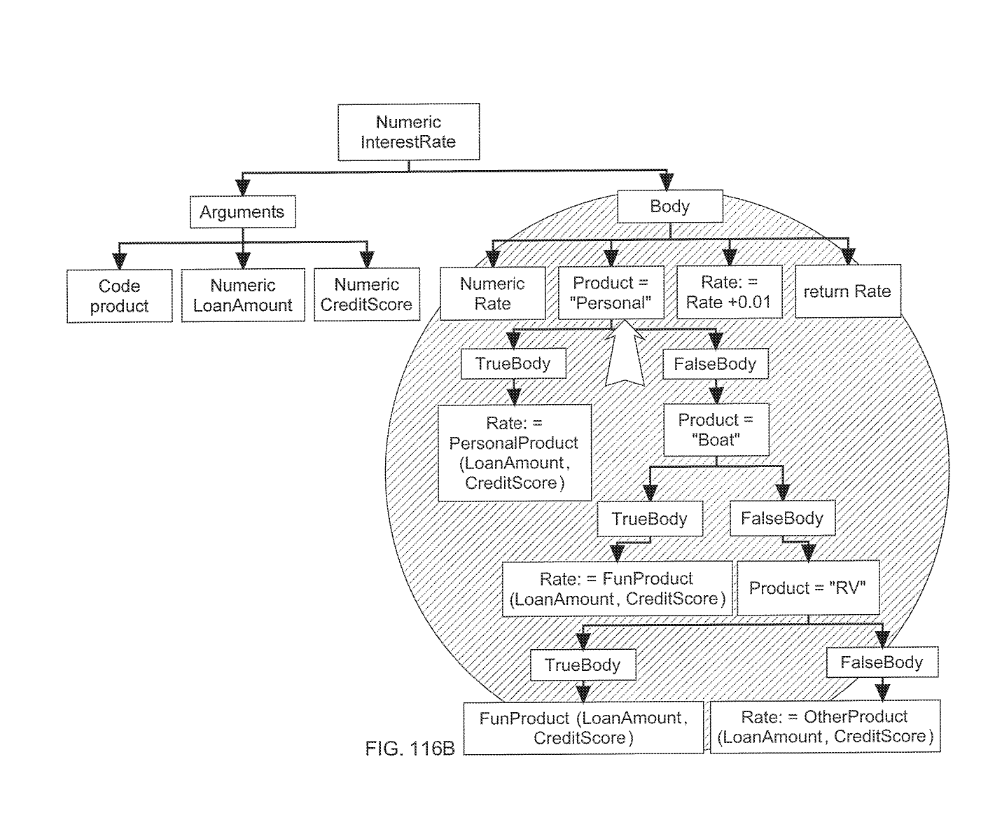

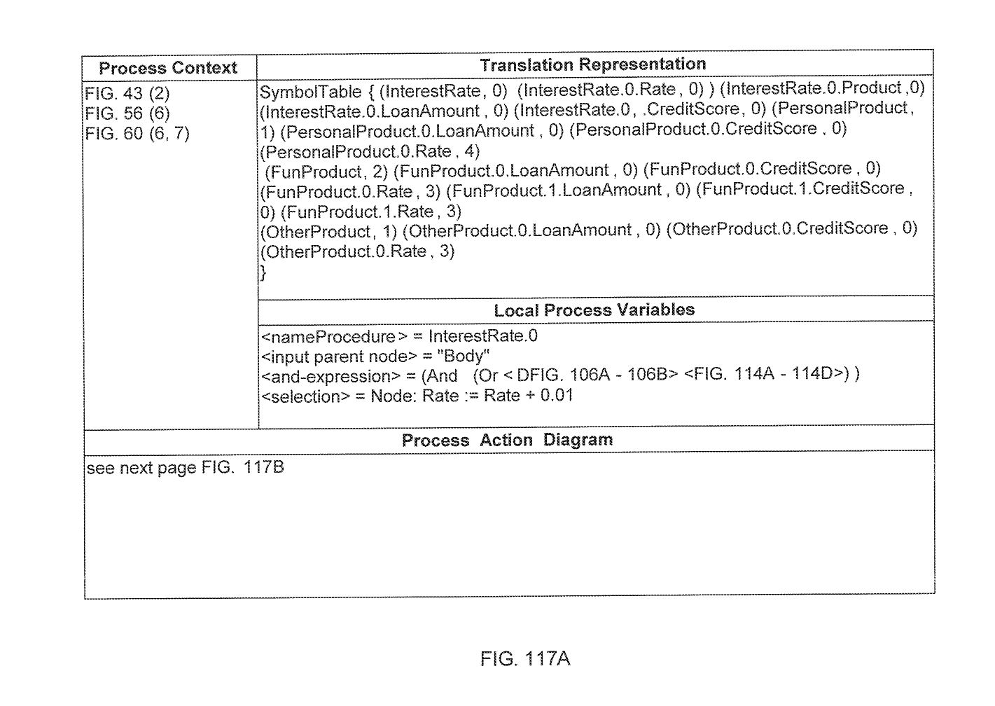

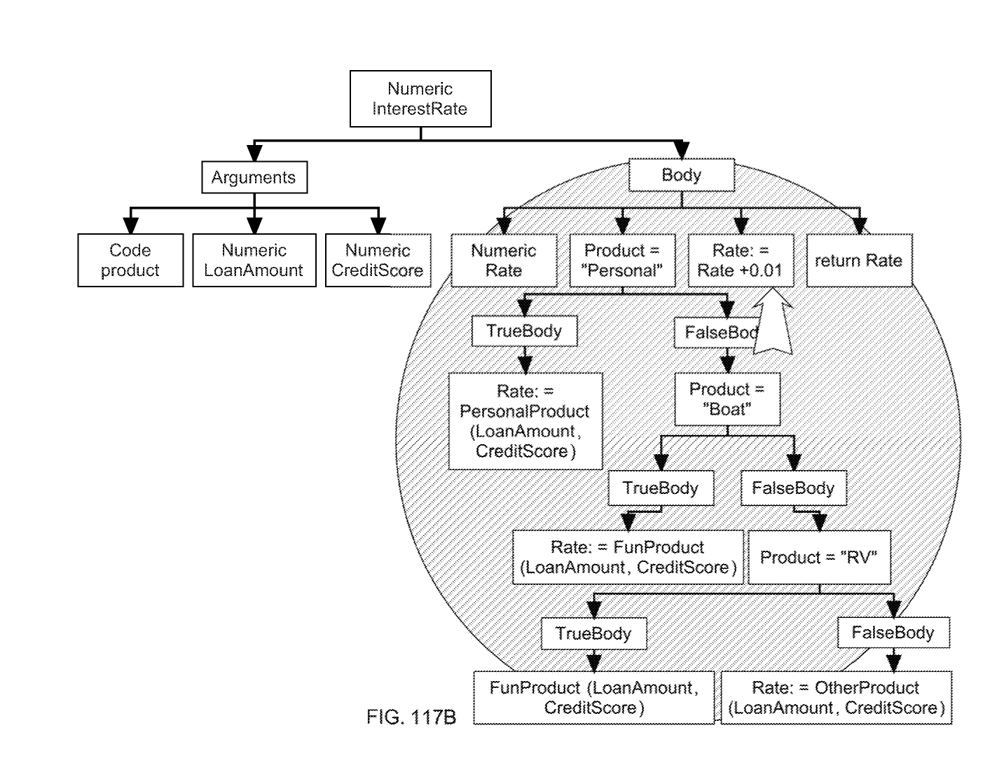

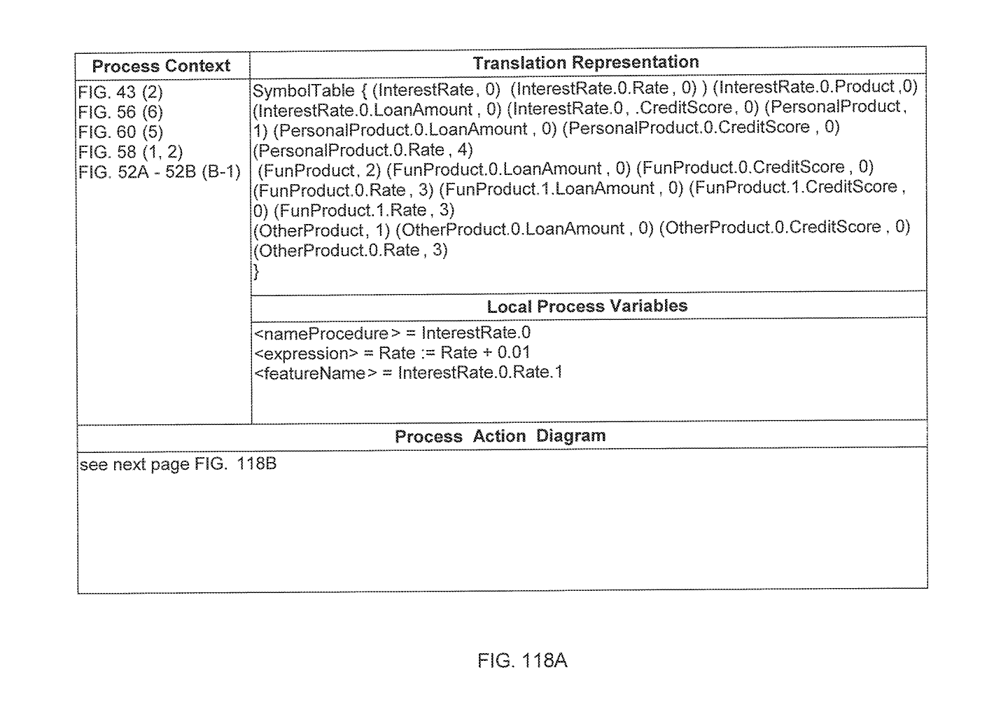

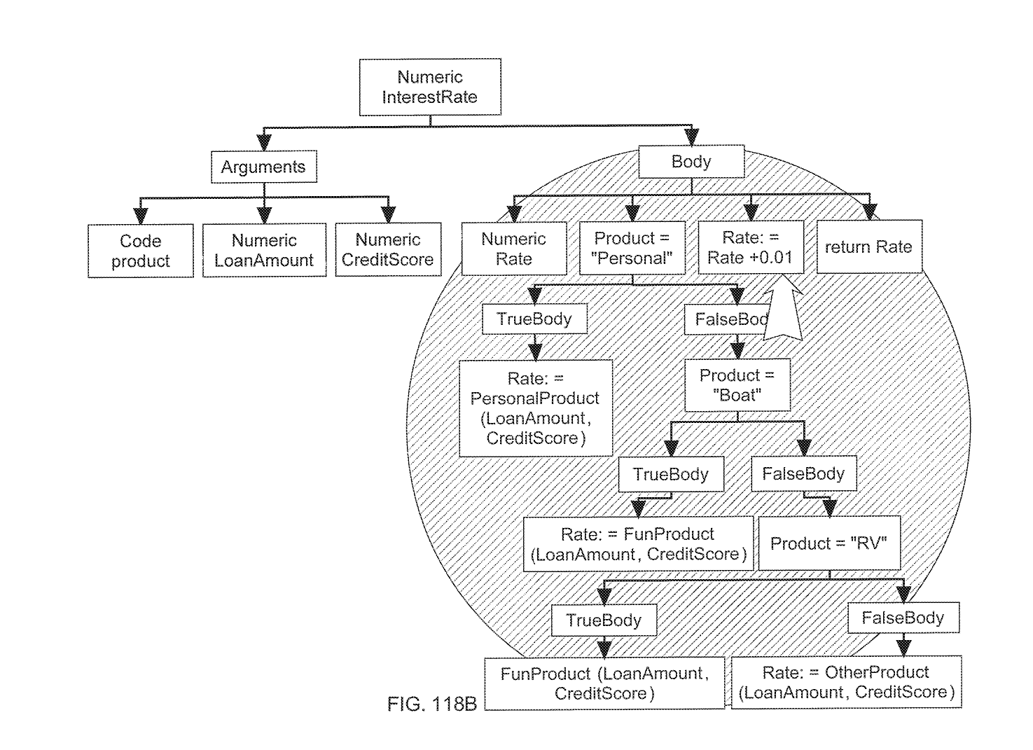

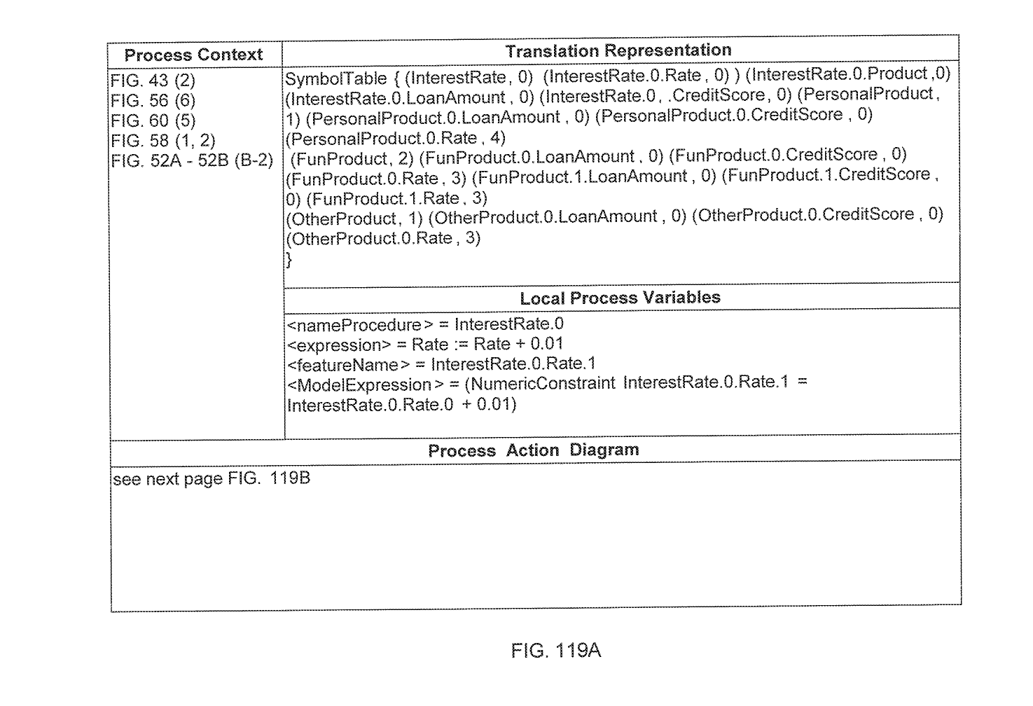

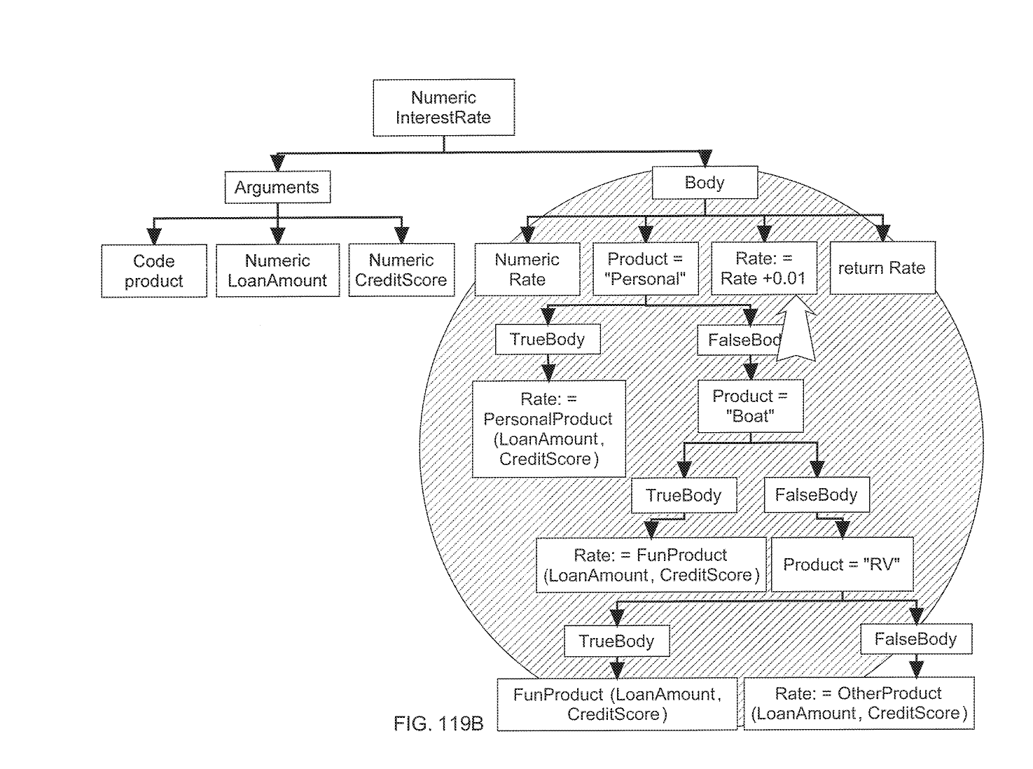

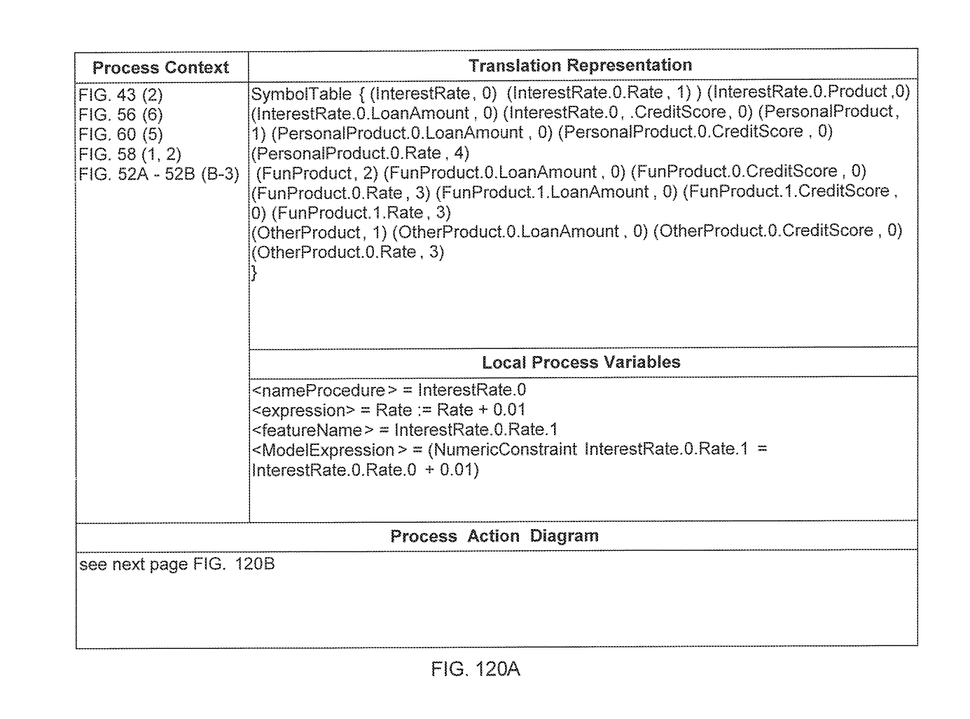

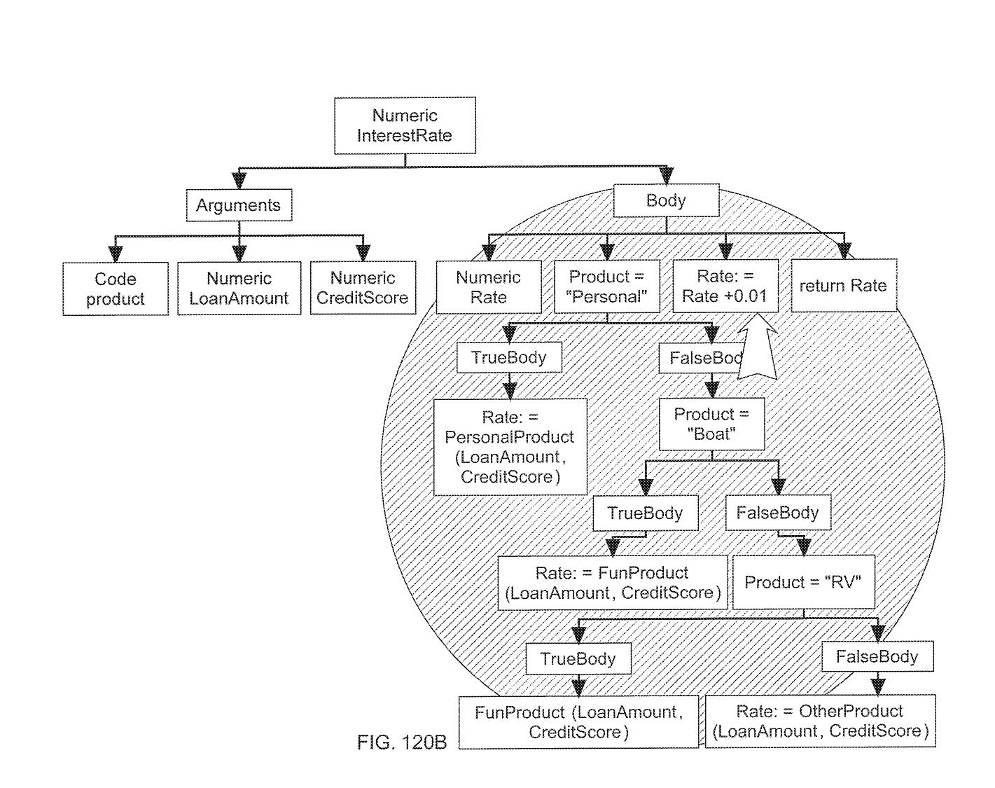

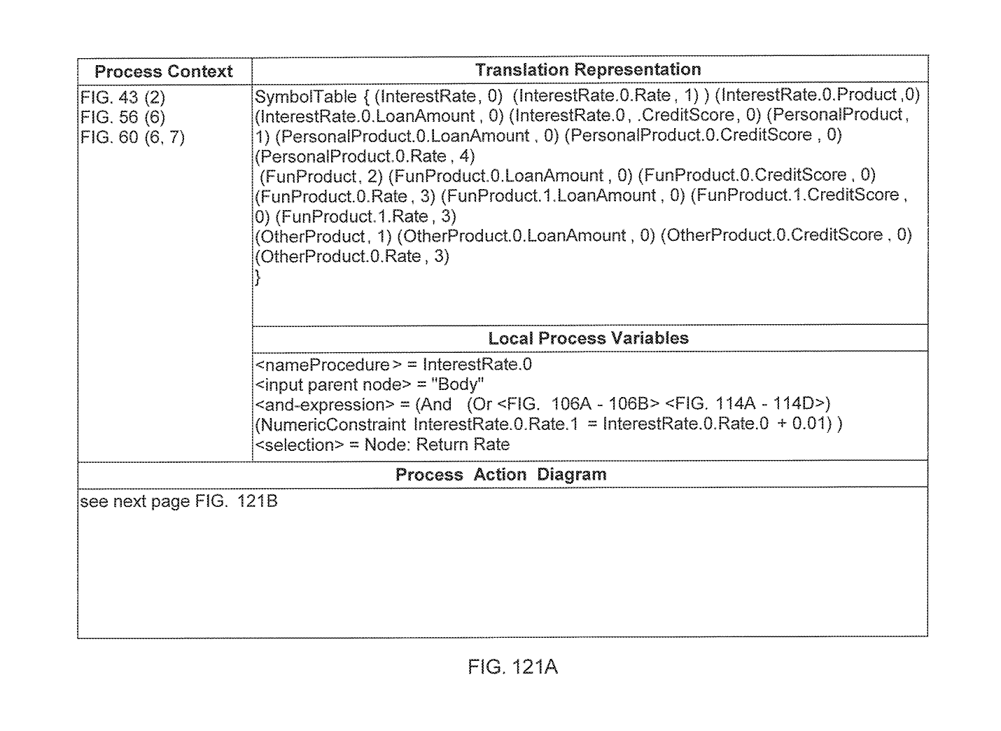

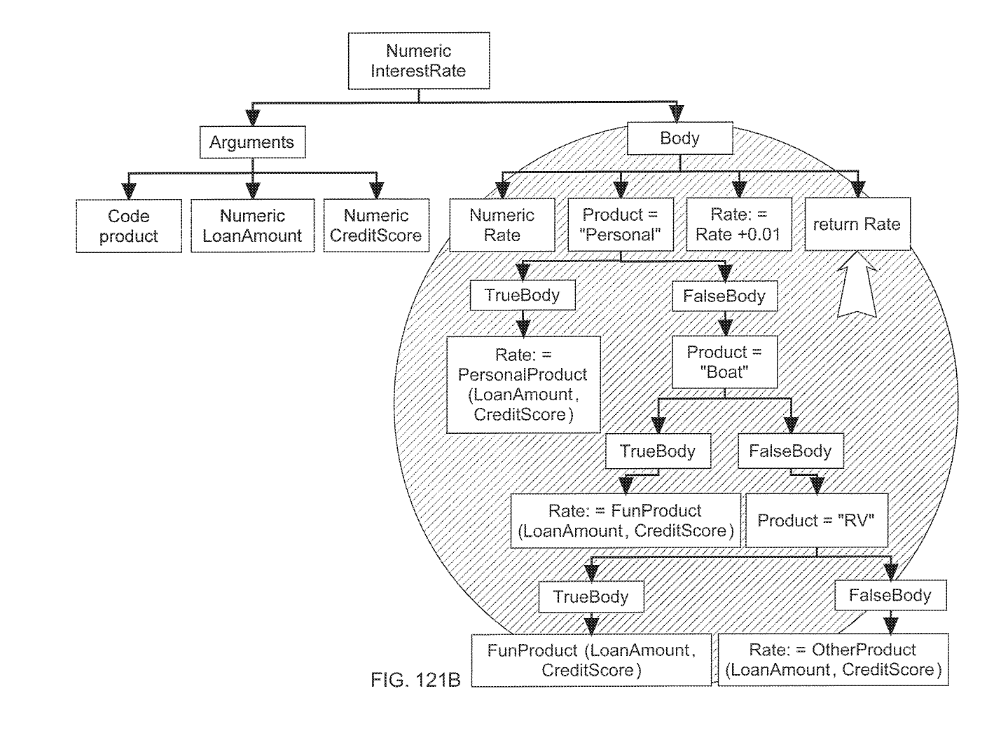

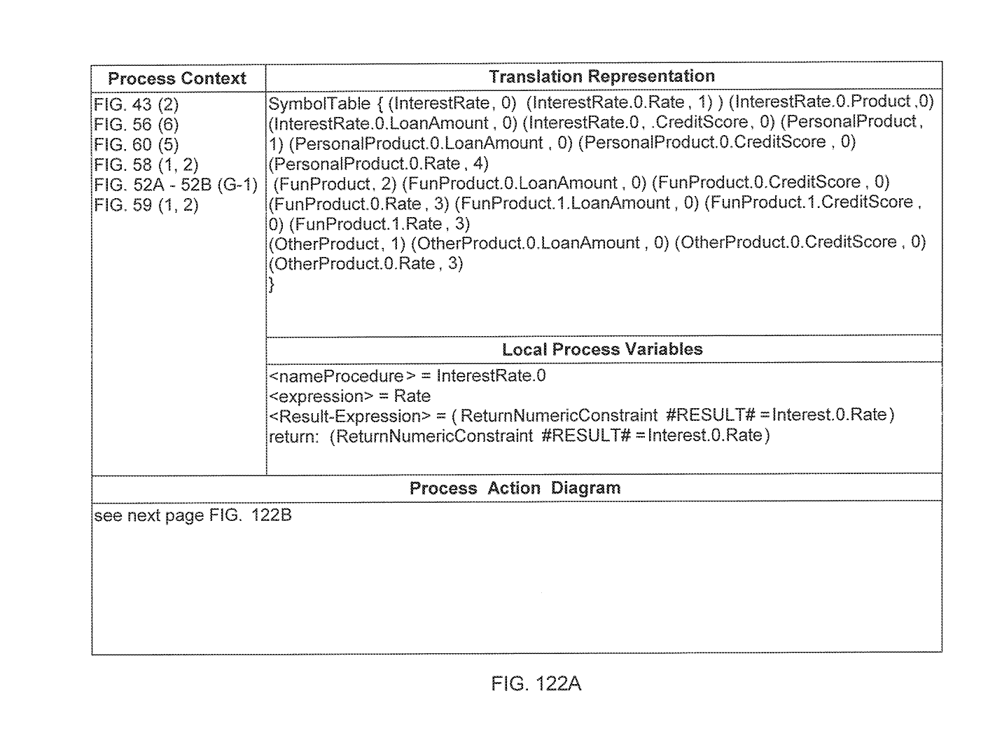

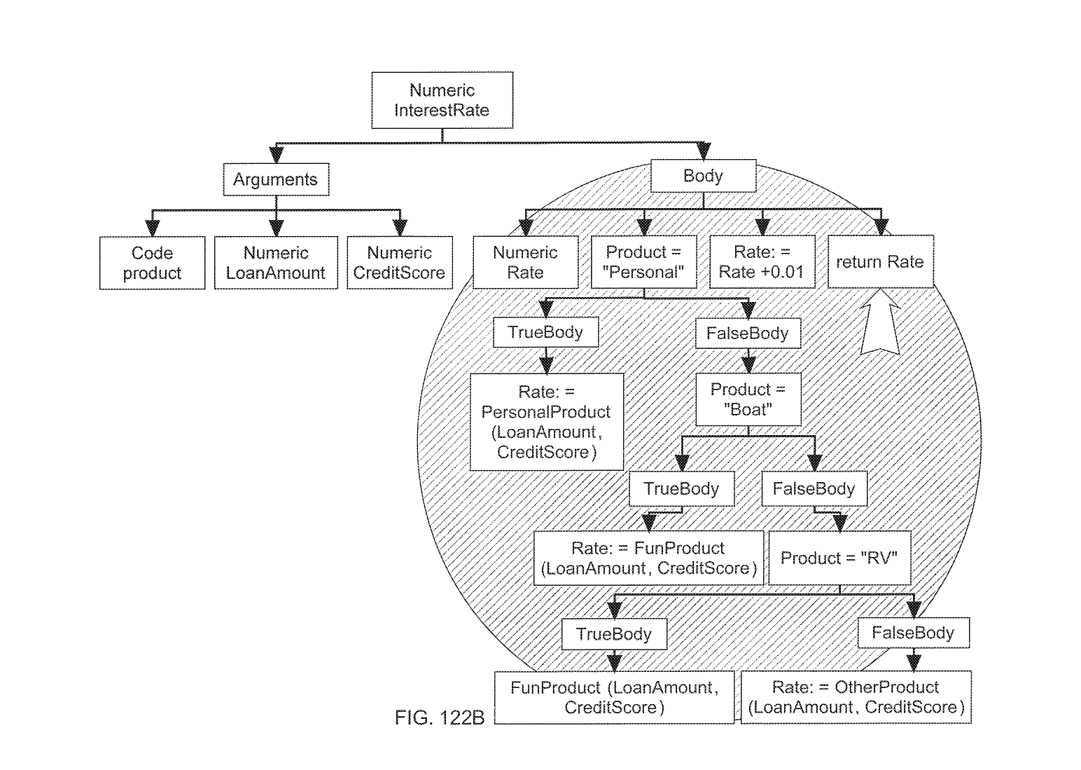

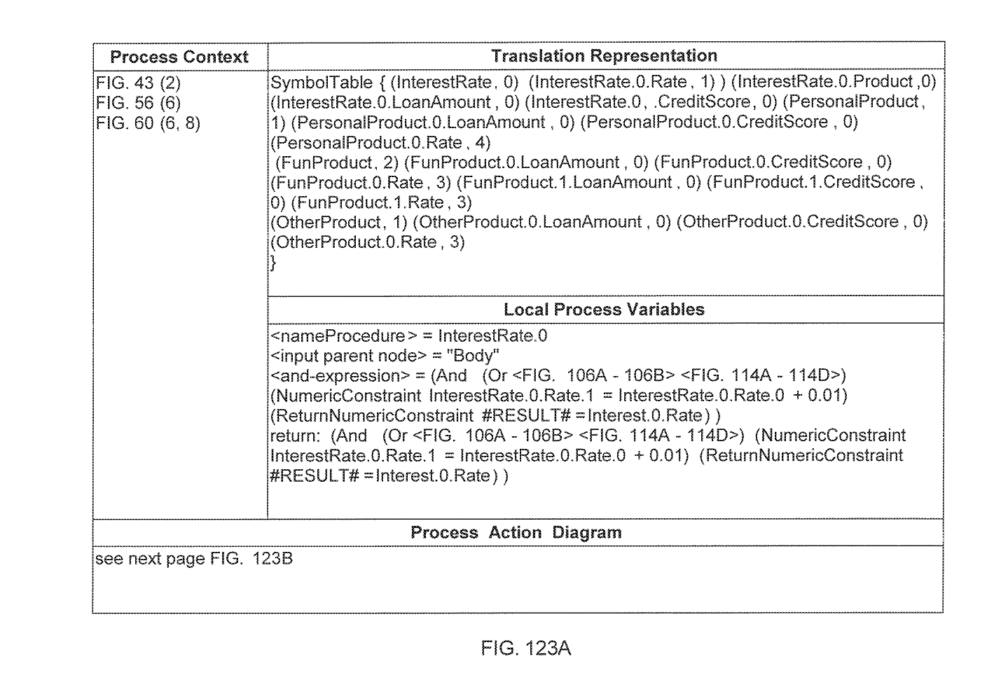

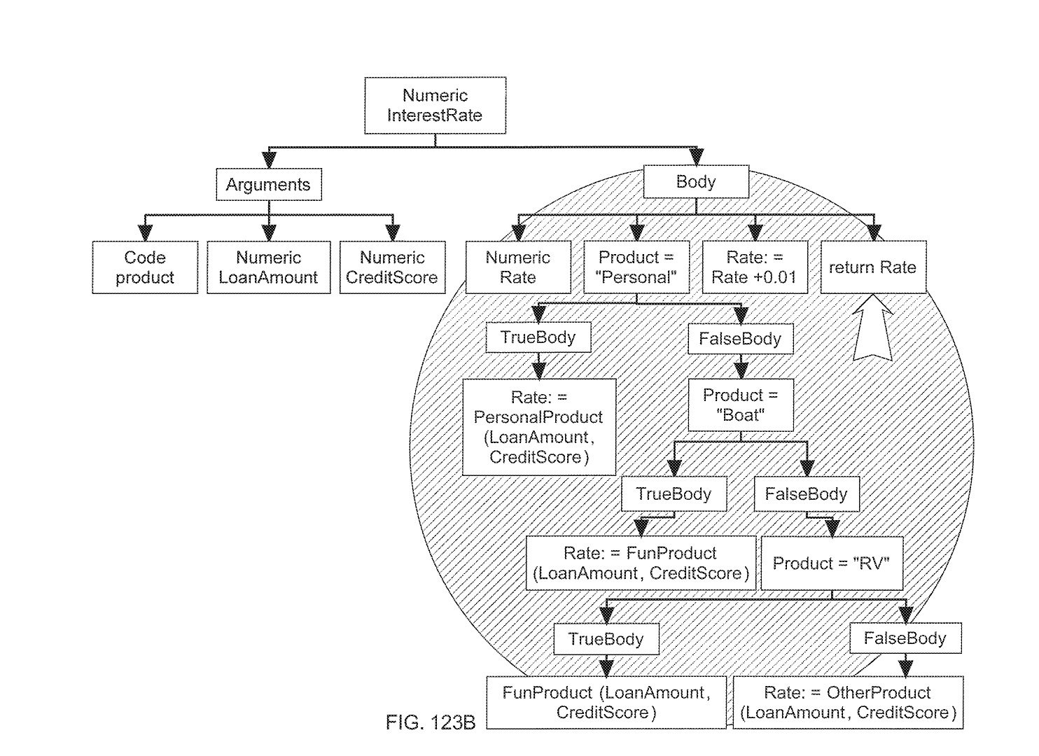

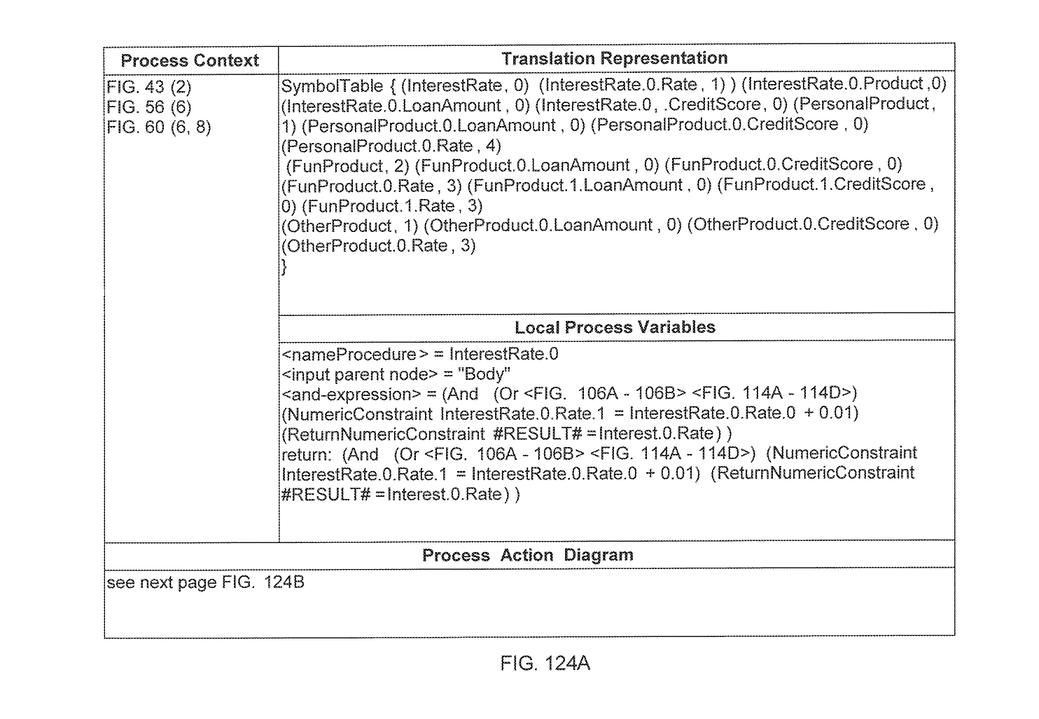

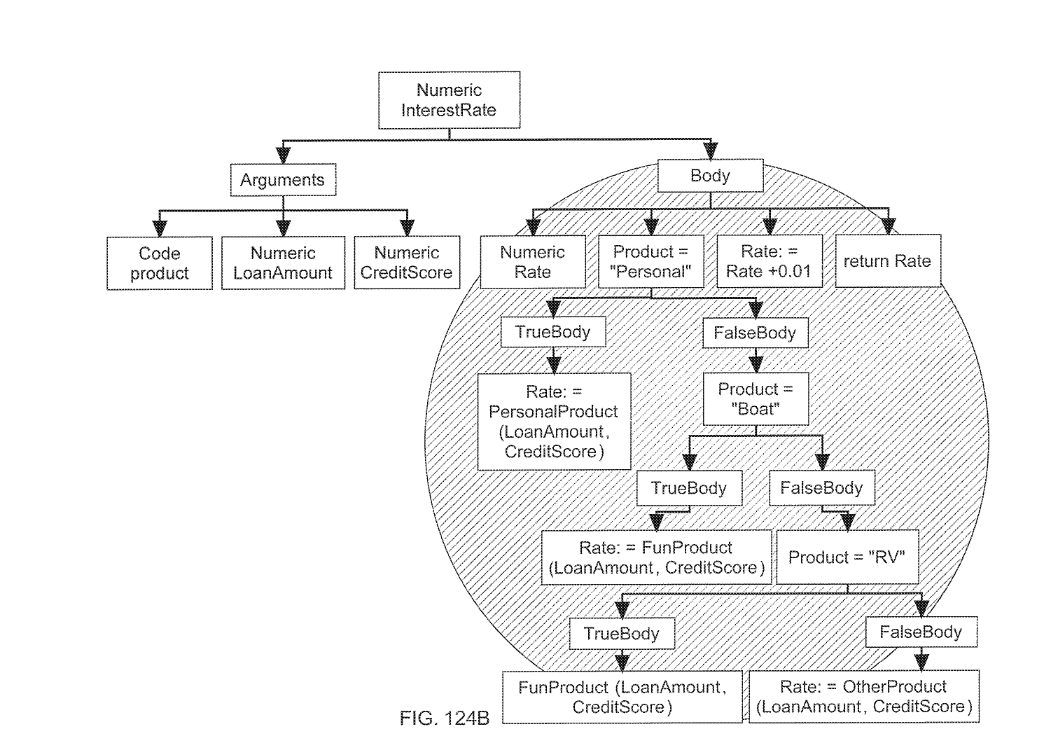

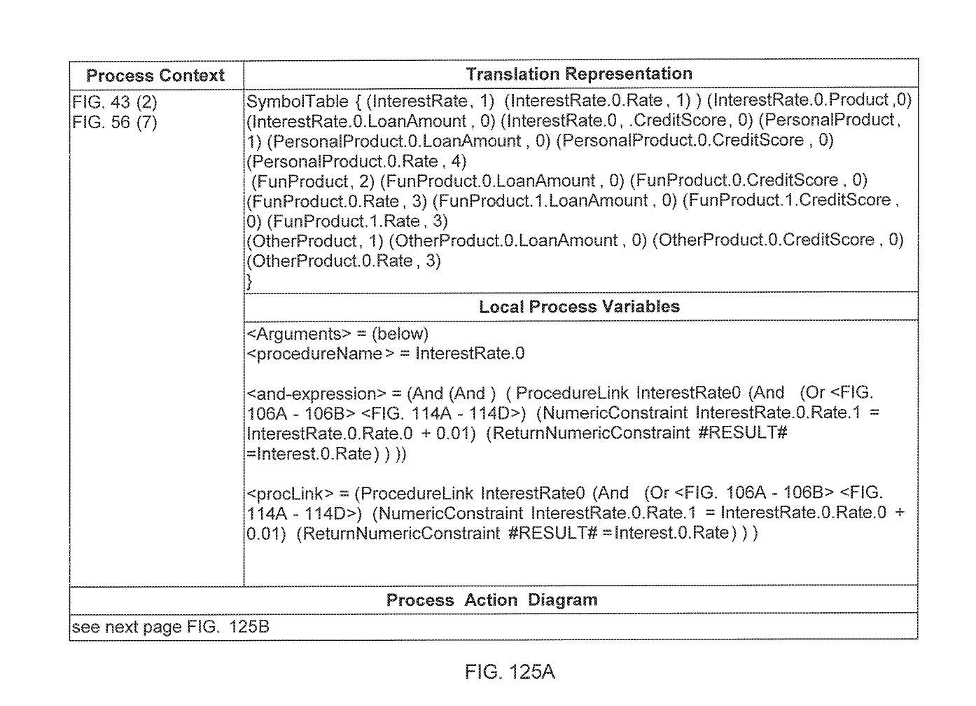

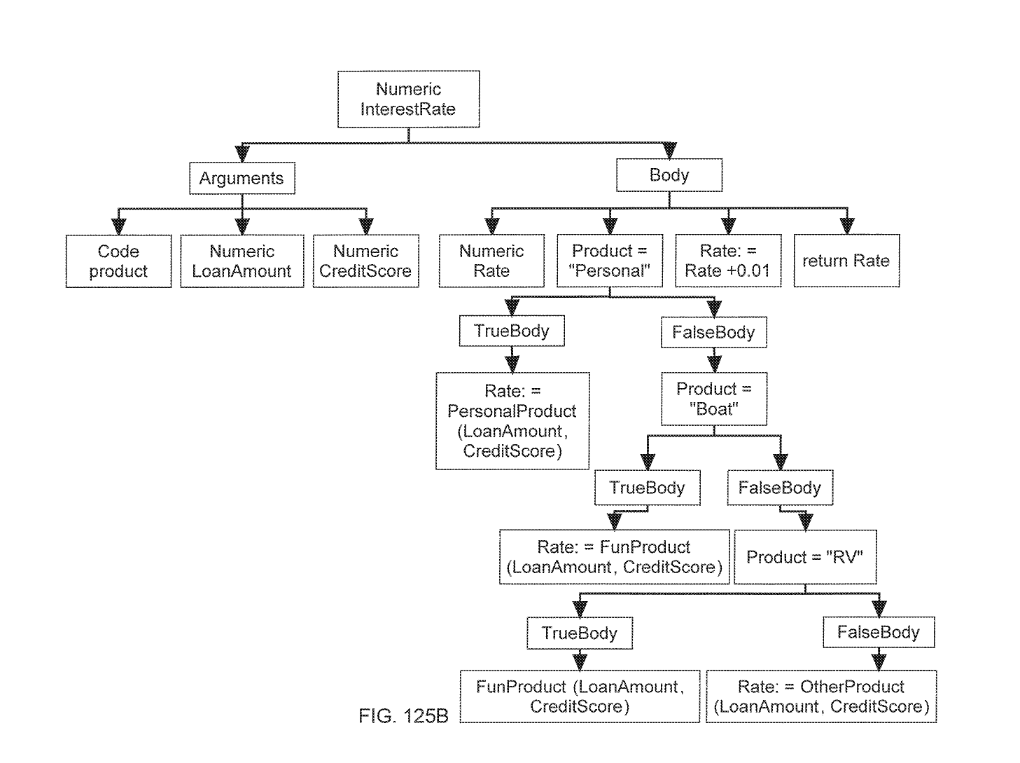

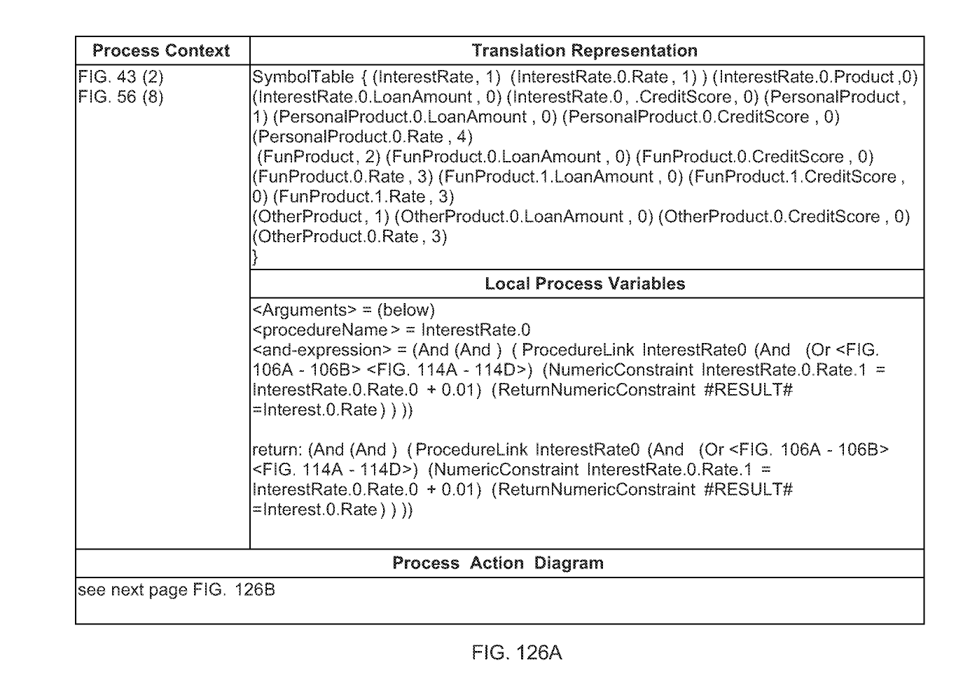

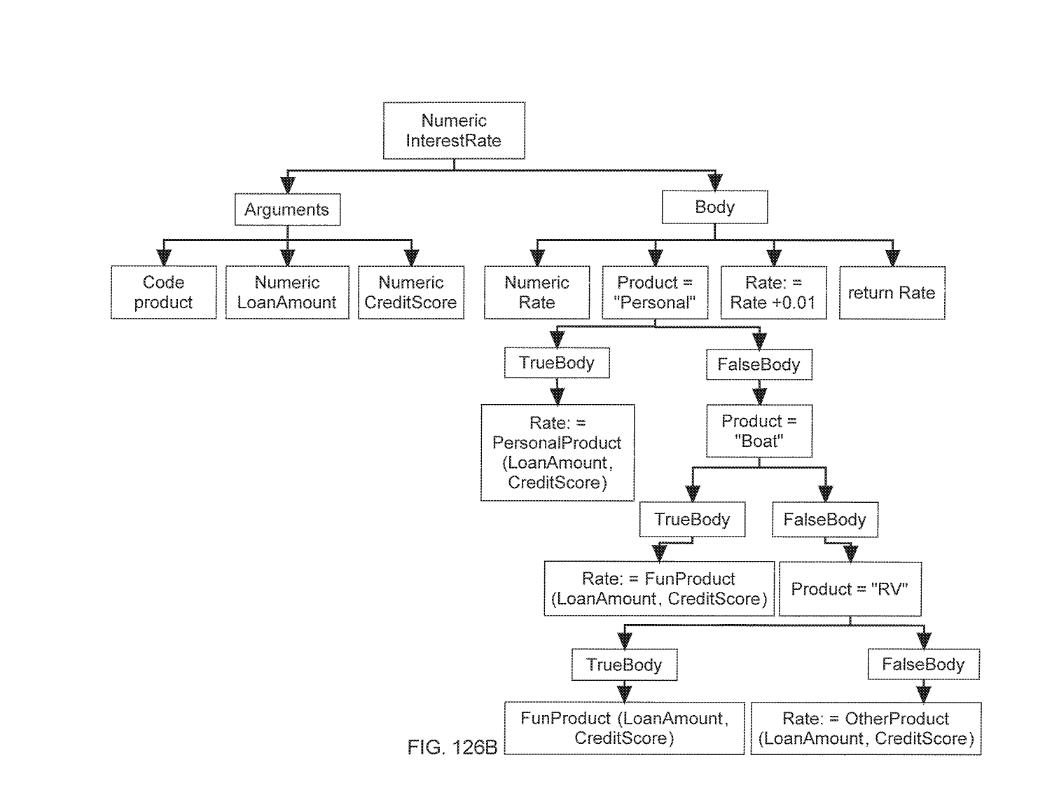

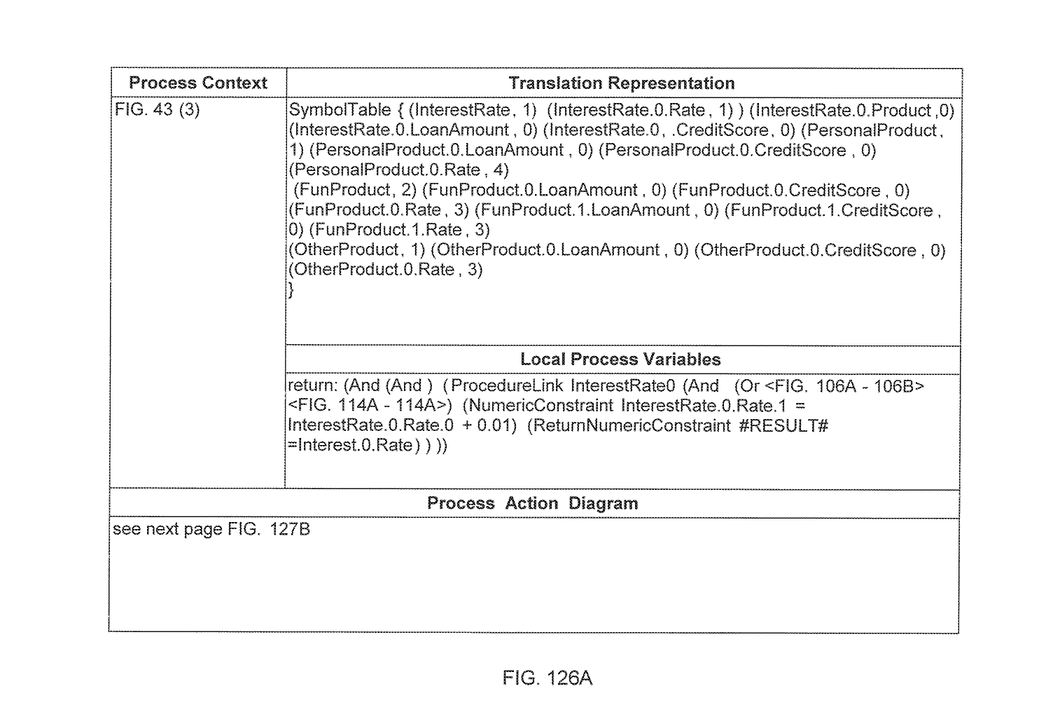

The main process for translation is the process Translate System (FIG. 43), which accepts the parsed system as input and returns a Model Logic representation as output. Translate calls subordinate processes that comprise the totality of its function.

A brief description of the subordinate processes is summarized below. The higher-level relationship of processes to one another is illustrated in diagram FIG. 44.
Substitute Data Elements (FIG. 45) accepts data expression as input, and substitutes variable state data elements for variables in the expression. See the Commentary section below.
Get Current Procedure Name (FIG. 46) accepts the source procedure name and returns an “instance” name that can be used for a specific procedure call. See Commentary below.
Get Current Variable State (FIG. 47) accepts a procedure name, and a variable name, and returns a state data element corresponding to the variable.
Get Next Procedure Name (FIG. 48) accepts a source procedure name and returns the next “instance” name that can be used for a specific procedure call. See Commentary below.
Get Next Variable State (FIG. 49) accepts a procedure name, and a variable name, and returns the next state data element corresponding to the variable
Increment Variable State (FIG. 50) accepts a procedure name, and a variable name, and increments the corresponding variable counter in the symbol table.
Negate Expression (FIG. 51) accepts a comparison expression as input and returns the negation of the expression.
Statement Translate Table (FIGS. 52A-52B) accepts a program statement as input and identifies the translation action for each category of program operator (statement).
Add Variable (FIG. 53) accepts a variable as input and adds it to the Symbol Table.
Translate Assignment Expression (FIGS. 54A-54C) implements the translation of the assignment statement.
Translate Conditional Statement (FIGS. 55A-55B) implements the translation of the conditional statement.
Translate Procedure (FIG. 56) accepts a parse tree of a procedure as input, and returns the corresponding model logic expression.
Translate Procedure Arguments (FIGS. 57A-57B) accepts the “arguments” sub-tree of a procedure parse tree and the procedure call statement, and returns the model logic corresponding to the argument declarations and bindings.
Translate Program Statement (FIG. 58) governs the translation of program statements using the Statement Translate Table (FIGS. 52A-52B).
Translate Return Statement (FIG. 59) implements the translation of the return statement.
Translate System (FIG. 43) accepts a parsed system as input, and returns the corresponding model logic as output.
Translate Statement Block (FIG. 60) implements the translation of the statement bloc structure.

Example

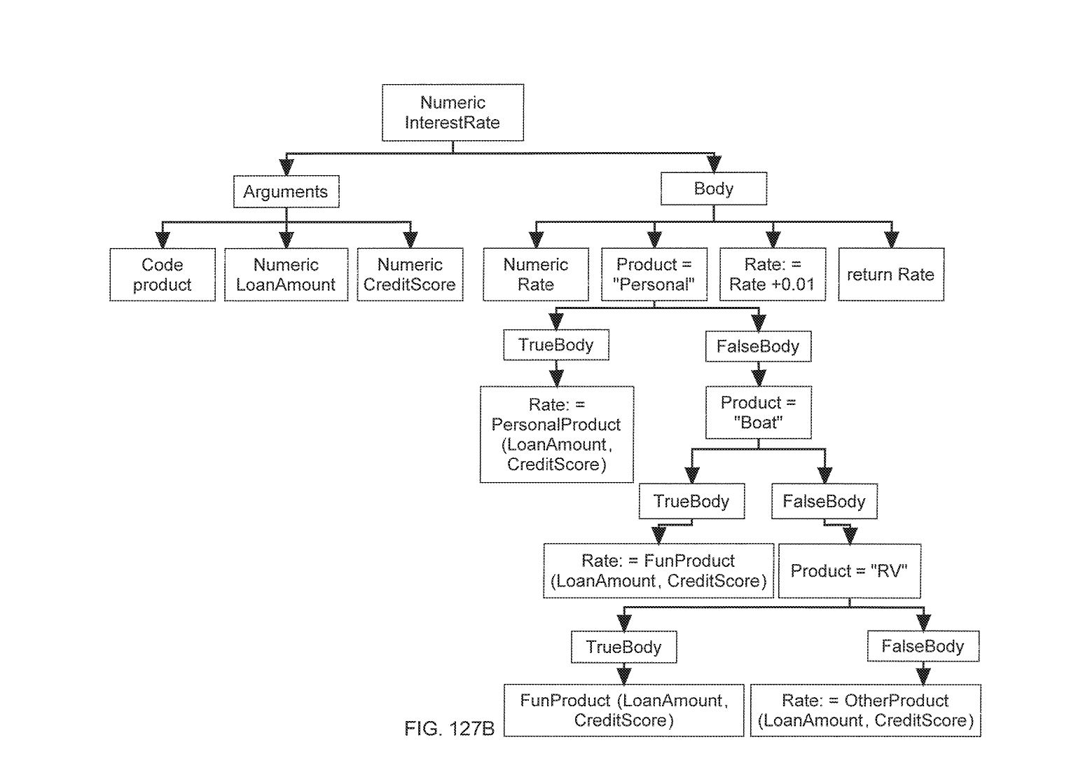

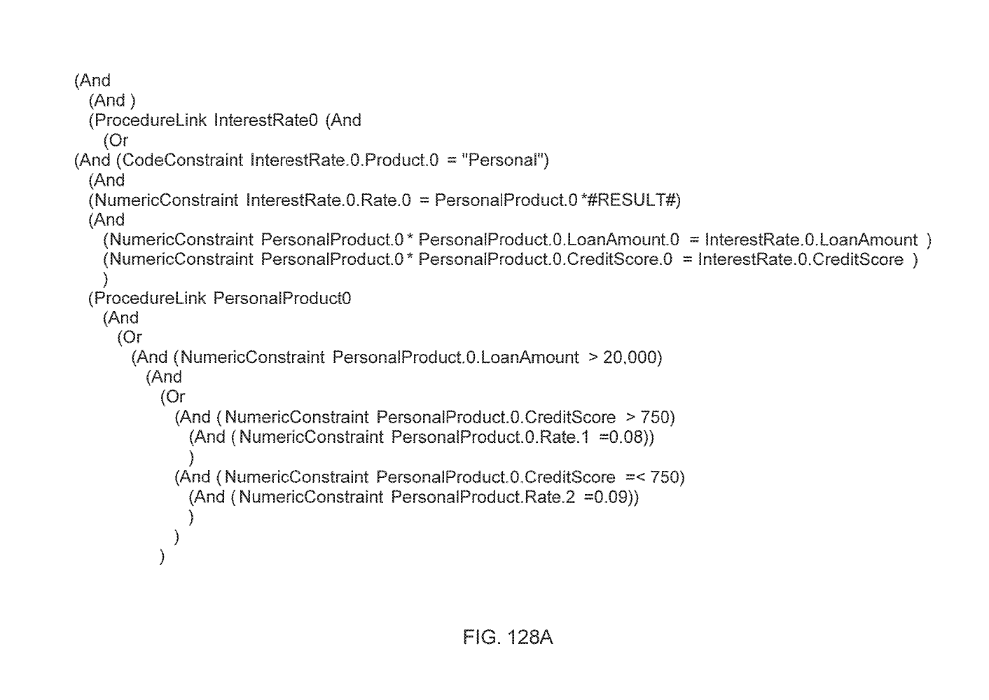

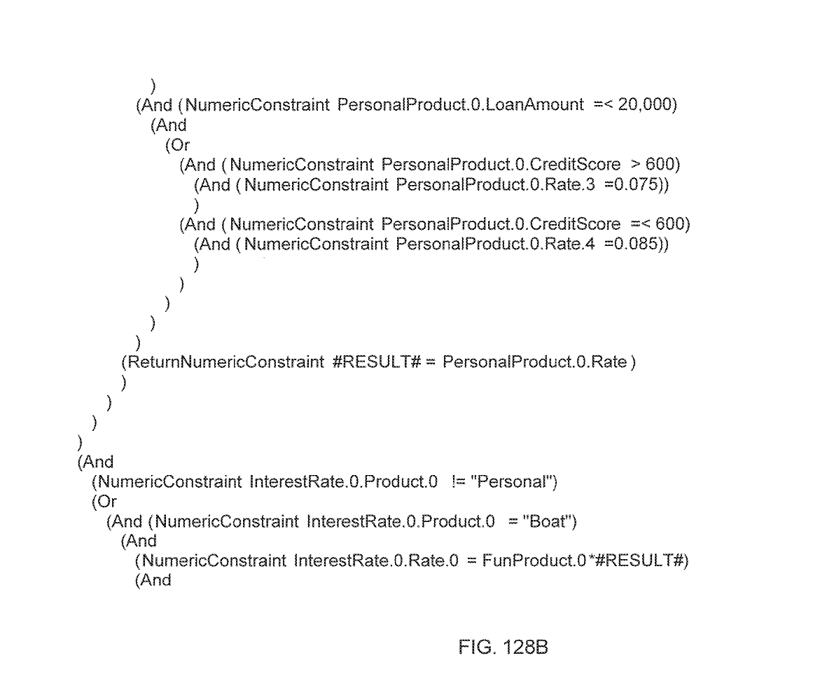

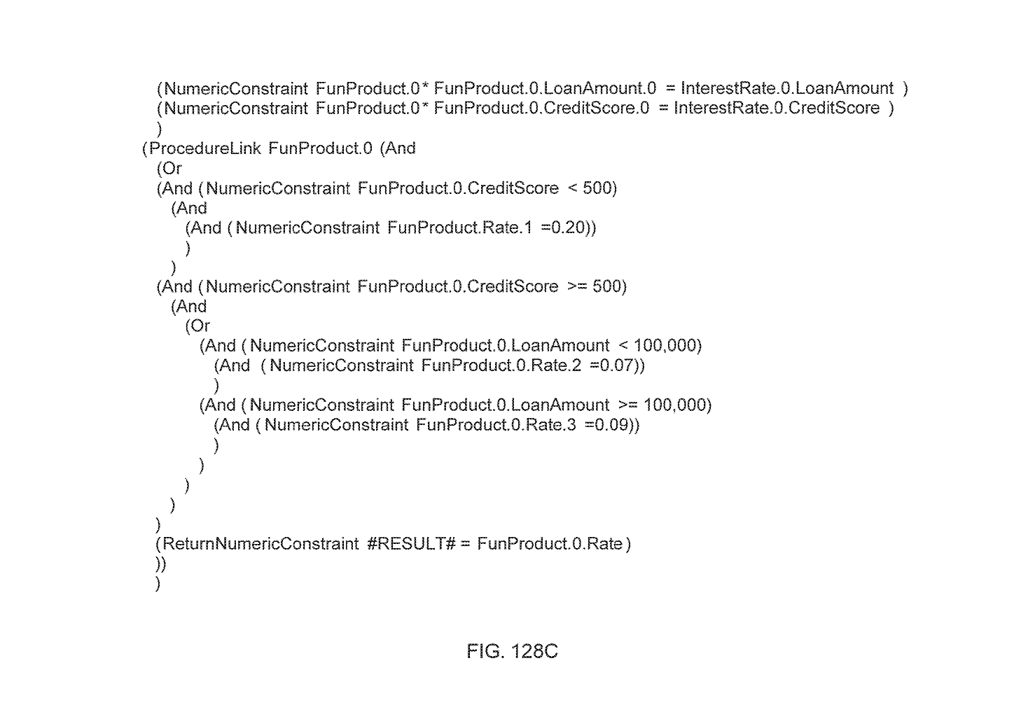

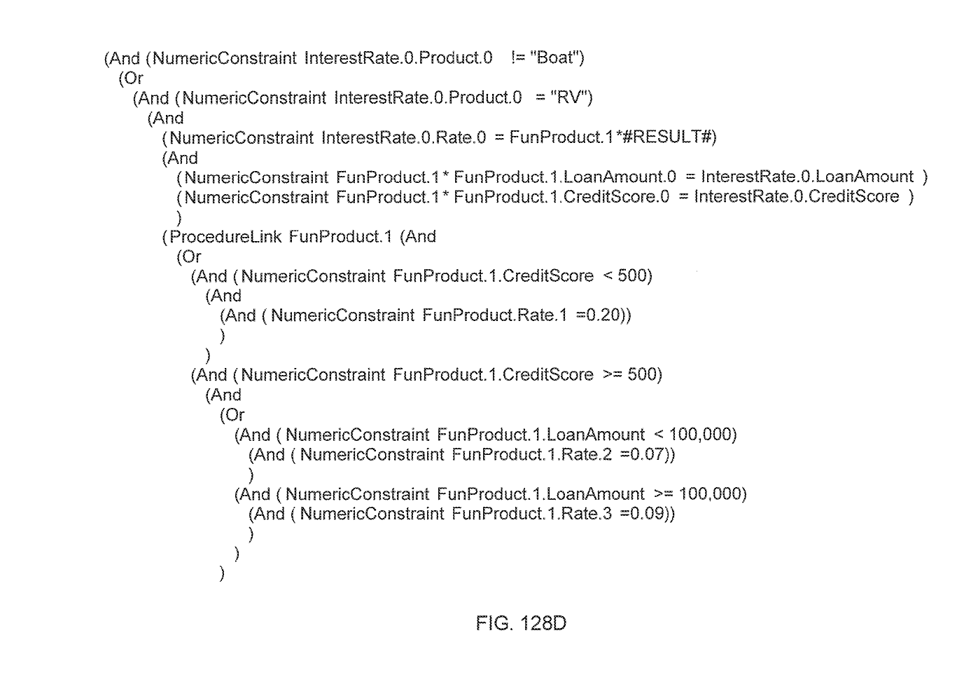

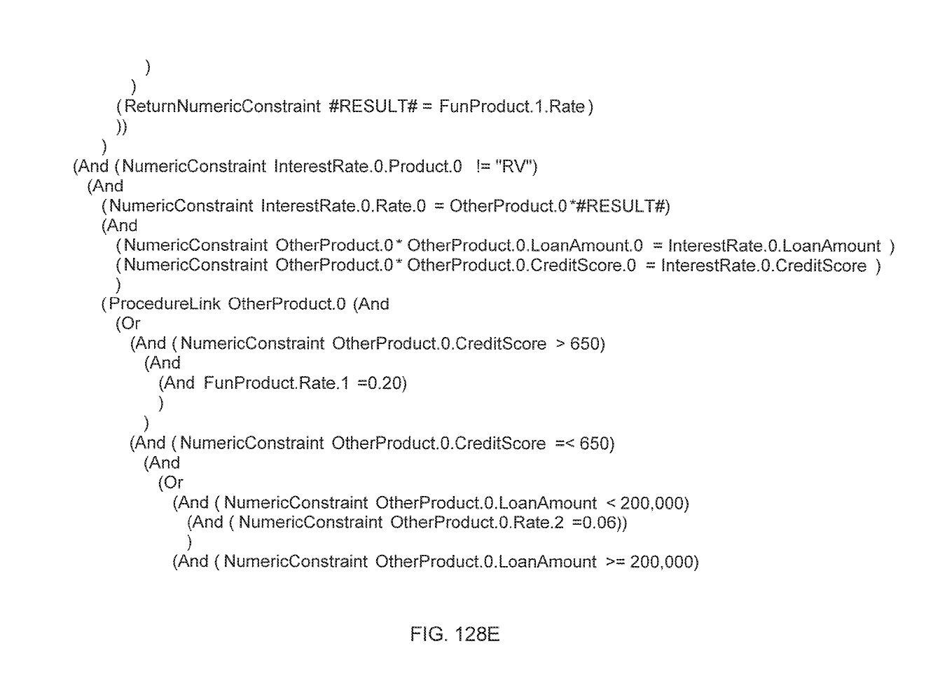

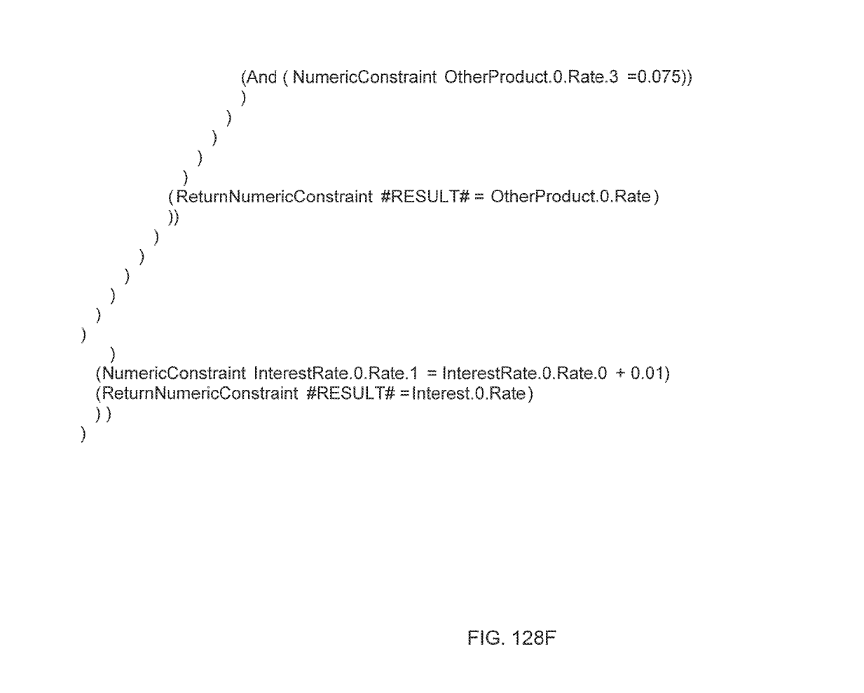

FIGS. 61-128F illustrate an example of the translation processes in action, translating the InterestRate example system. The illustrations show in detail the translation of the entry-point procedure: Interest. Translation of subordinate procedures (which are invoked through Procedure Calls) is not shown in detail due to length and repetition.
Each diagram in this series is a block diagram showing the state of the translation processes, and is broken into four sections:
The top-left section shows the “stack” of the processes in action. Each time a process is invoked, its name is added to the bottom of the queue list. The numbers to the right of the process diagram name are the node context within the corresponding process.
The top-right section contains the translation data areas defined above, principally the Symbol Table.
The middle section on the right contains the data elements of the active process. Each process defines working data that it uses to accomplish its responsibilities. These are shown here in action.
The bottom area is for informal information and typically contains diagrams that are helpful in providing context for the processes in action.

There are, in some cases, supplemental diagrams that represent structures that were too large to fit into the above format. These are referred to using angle brackets, as in “<FIG. 106A-106B>.”

The diagrams, in conjunction with the process descriptions and graphs, are self-explanatory. The following is a high-level description of the process that summarizes the corresponding actions of the series of diagrams.

In FIG. 61, Translate System (FIG. 43) is the starting point process. It establishes the entry-point procedure, and invokes the translate procedure to translate the system.

In FIGS. 62A-63B., Translate Procedure (FIG. 56) initializes a model logic “And” construct into which the procedure definition will be inserted, and then invokes Get Current Procedure Name to get a unique identifier for the instance of the entry point procedure.
In FIGS. 64-68, Get Current Procedure Name (FIG. 46) creates the appropriate entry in the symbol table, and returns the first corresponding name. The need for this process is described in the Commentary section below.
In FIGS. 69A-86B, control has returned to Translate Procedure, which invokes Translate Procedure Argument (FIGS. 57A-57B) to translate and bind arguments. Typically, this process will declare the new procedure's argument variables, and bind them to the call arguments. Since this is the entry point procedure, there are no bindings and the process returns an empty “And.”
In FIGS. 87A-124B, control has returned to Translate Procedure, which invokes Translate Procedure Statement Block (FIG. 60) to translate the body of the procedure. As the diagram at the bottom of the block charts illustrates, Translate Procedure Statement Block processes each subordinate node in its graph. Each of these nodes corresponds to a program statement. Each statement is matched in the Program Statement Translation Table (FIGS. 52A-52B), which contains the corresponding translation actions for the selected statement. The table's actions return the translated result, which is incorporated into the growing model logic statement. When all child nodes have been processed, Translate Statement Block returns to Translate Procedure.
In FIGS. 125A-127B, Translate Procedure (FIG. 56) finishes the process and returns the overall model logic result, which is captured in FIGS. 128A-128F.

Translation

There were two issues introduced in the summary that require particular attention in the translation process: program variables and data elements. Further, there is a brief comment about combining parsing with translation. The first issue is the relationship between data elements and program variables. The second issue is instances of program procedures.

Model Data Elements and program variables are not synonymous. A Data Element in a FIOSM has one fixed value, whereas a program variable can take on many values (one for each assignment) during the execution of its program.

When a variable is used in another program operation, for instance, on the right side of an assignment, its value at that particular program execution state is used in the calculation. Thus, looking at an entire program, a variable can have many values, at a particular program state, it can have only one value.

A program variable at a particular state is equivalent to a data element. Translation uses this observation to convert variables into data elements, and this is reflected in the above procedures, since all variables are translated to a variable state representation. It is worthwhile to note that these state data elements are translated back in the model formatting process.

Program procedures are the second particular issue that requires attention. Procedures may be called more than one time in a system. In fact, they usually are called several times at various differing points in the system. The Interest Rate system calls the FunProduct Procedure twice, once for an “RV” product, and once for a “Boat” product.

In the model logic, these differing invocations correspond to different values for <ProcedureName> in the ProcedureLink structure. To illustrate this point: in the example above, there are two invocations of FunProduct. The <ProcedureName> values are FunProduct0 and FunProduct1. Translation is responsible for assuring that these names are generated correctly. The symbol table is the representation used to keep track of such issues.

Finally, a comment is appropriate on parsing and translation. These functions are both, in essence, translation functions and could be combined into one process. This has not been done in the Example for the purpose of clarity. Parsing programming language source to a tree representation is a common activity in the field of computer science; the creation of Model Logic is not typical.

Tableau

The Tableau process takes the model logic (created in the Translate process above) as input, and creates a set of Model Containers as output. Each Model Container corresponds to a Pattern Model, as defined above.

The Tableau is a rules-based system, where each type of Term in Model Logic has a corresponding action. The action can be either or both:
Create another model logic term that is added to the Term-Queue, and/or
Create an expression in one of the Model Containers (Abstract, Numeric, or Code).
   The Tableau takes Terms from the Term-Queue, and applies the corresponding actions until the Term-Queue is empty.

The Model Generator stands above the Tableau to invoke the Fourier Elimination processes to assure consistency of the data model. The Model Generator also is the repository of the valid Model Containers, which correspond to the valid pattern models. The overall process is invoked with the process Generate All Patterns.

Tableau Processes

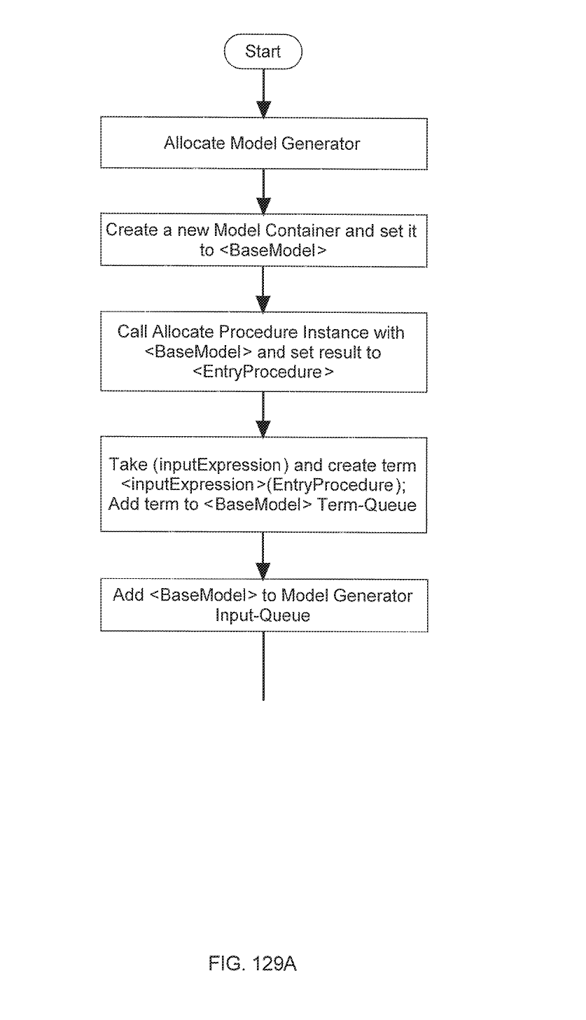

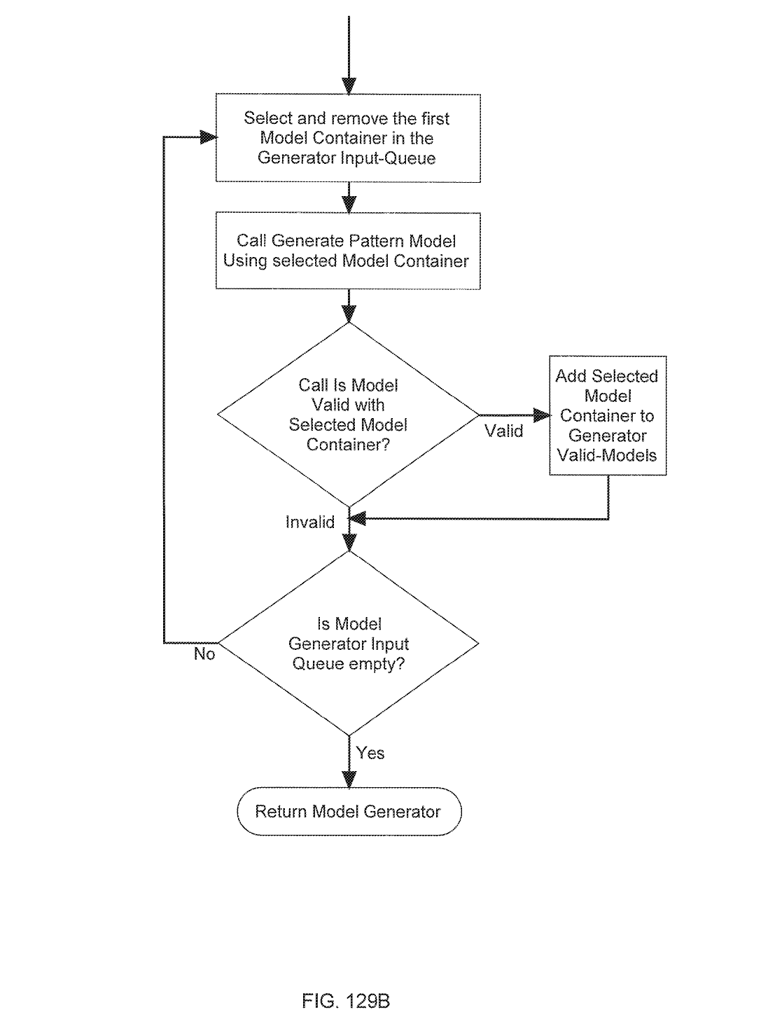

The main process for Tableau is the process Translate Generate All Patterns (FIG. 129), which accepts the model expression created by Translation as input and returns a Model Generator as output. The Model Generator's Valid-Model contains the set of resulting Model Containers. Like Translate, Tableau calls subordinate processes that comprise the totality of its function

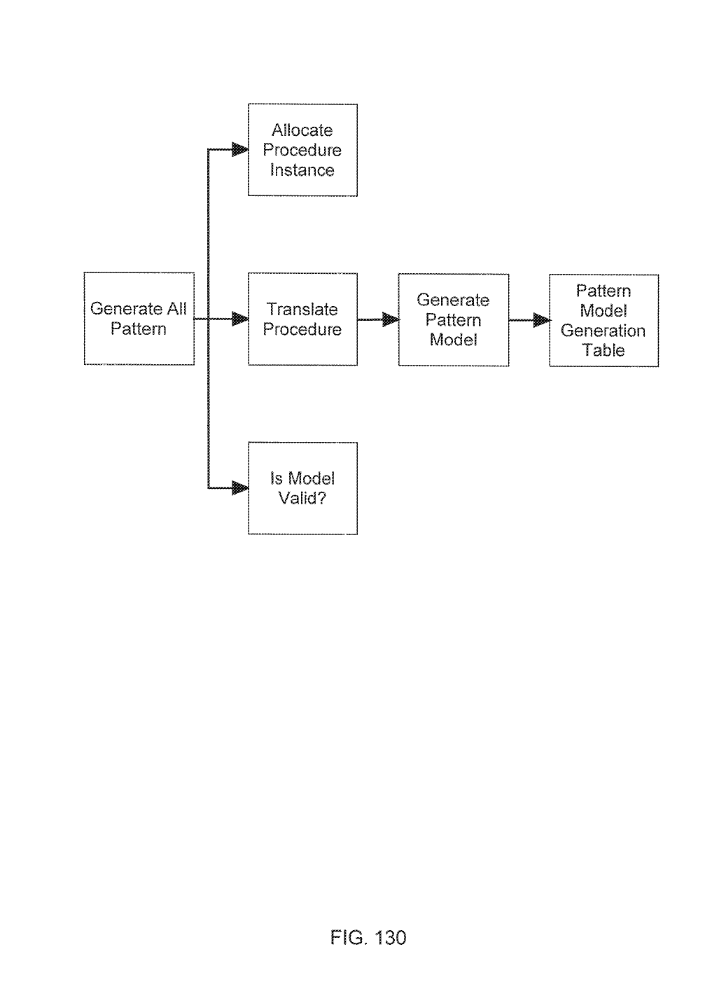

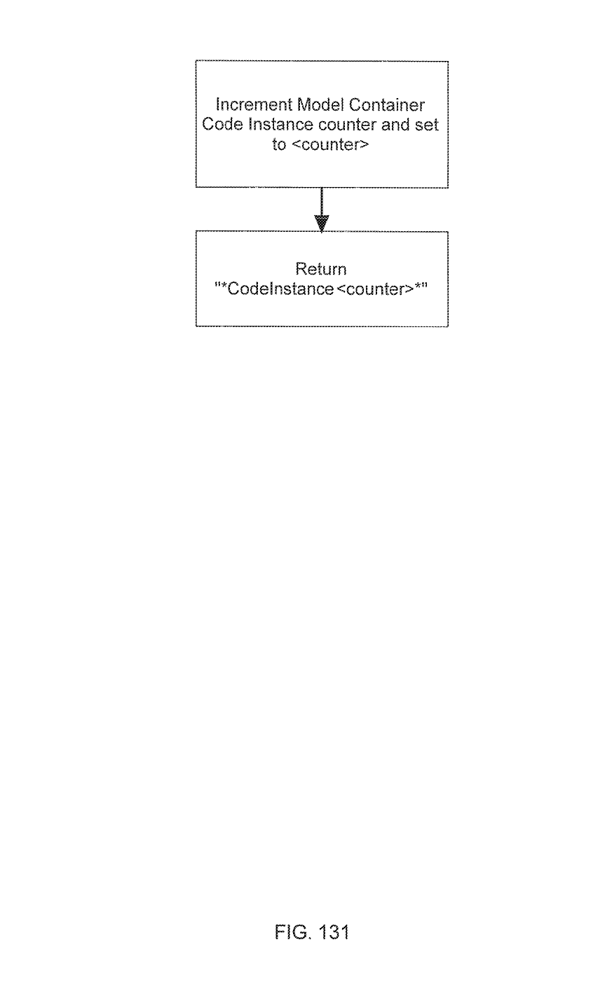

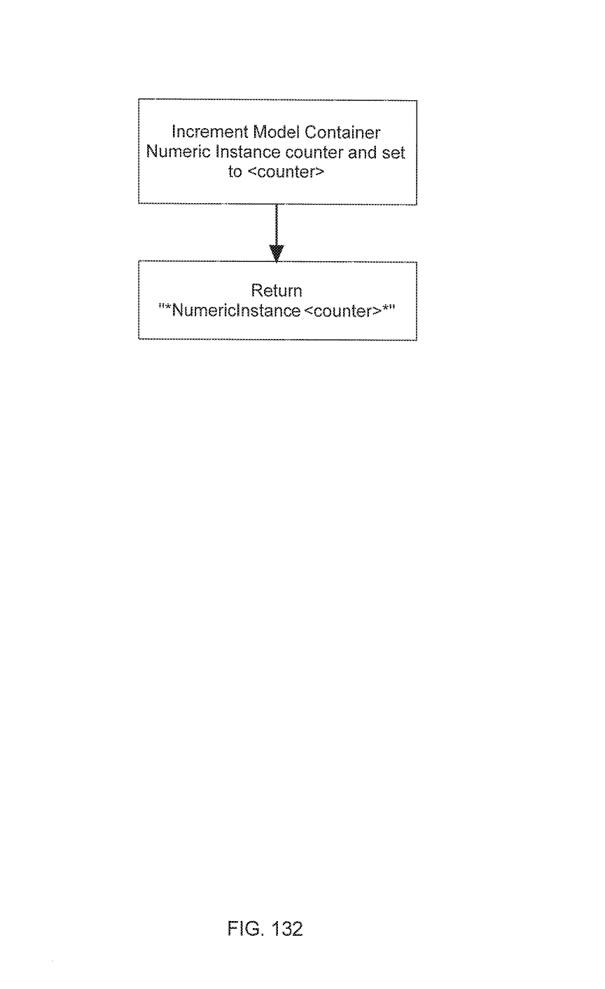

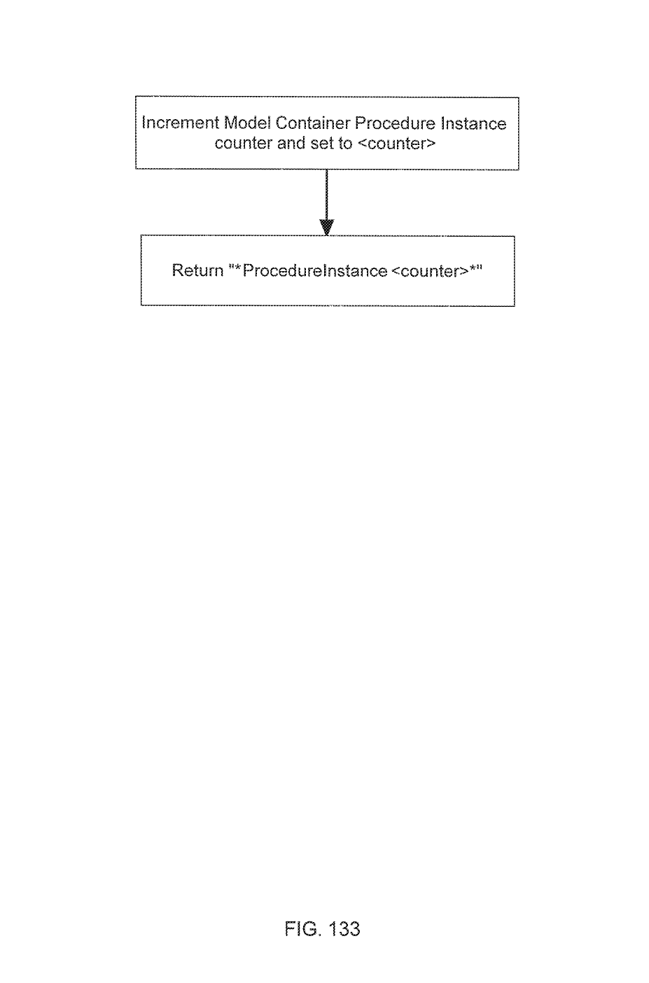

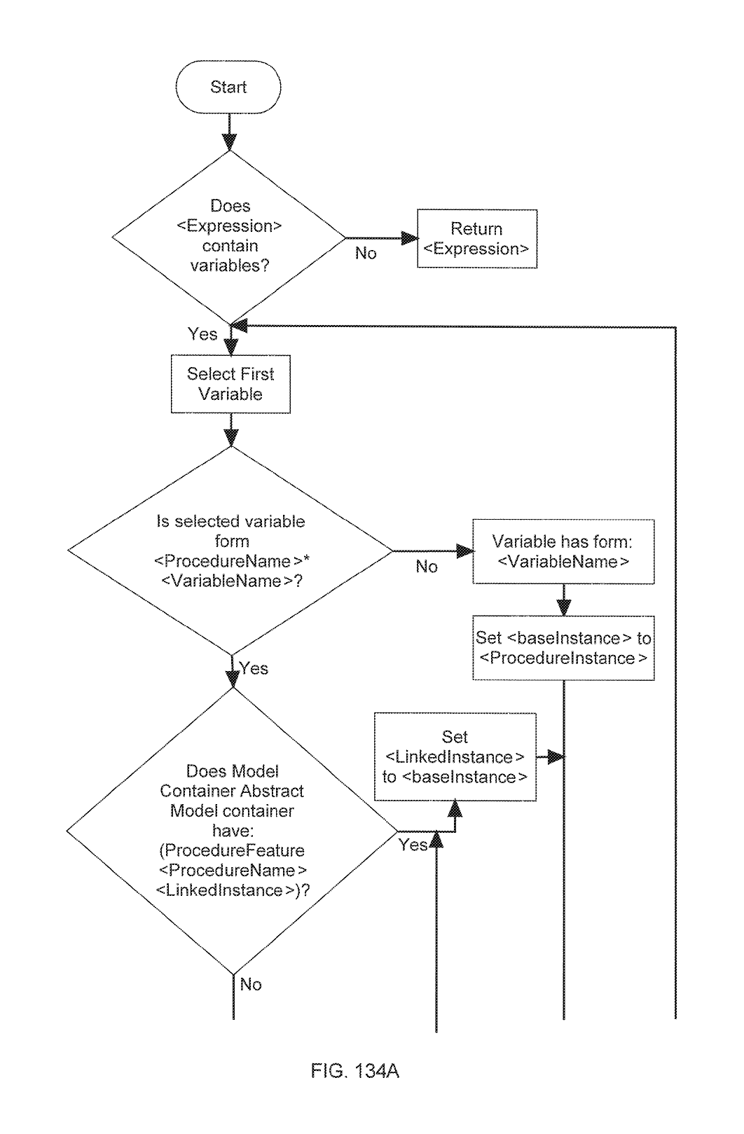

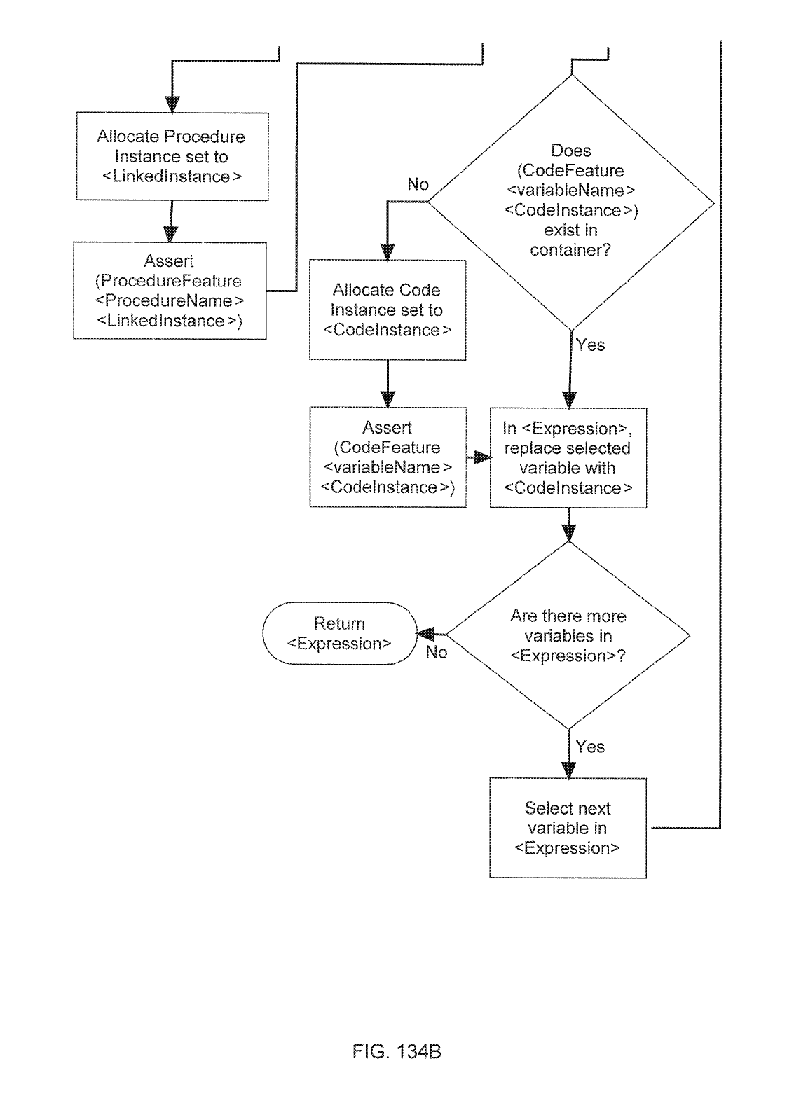

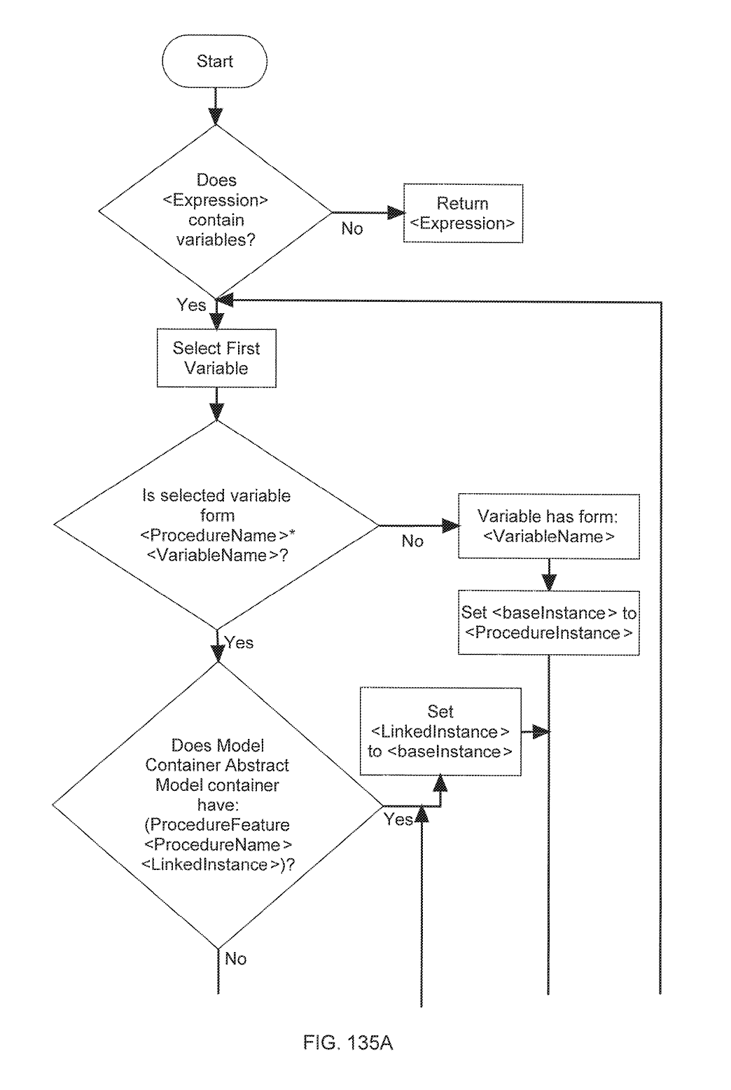

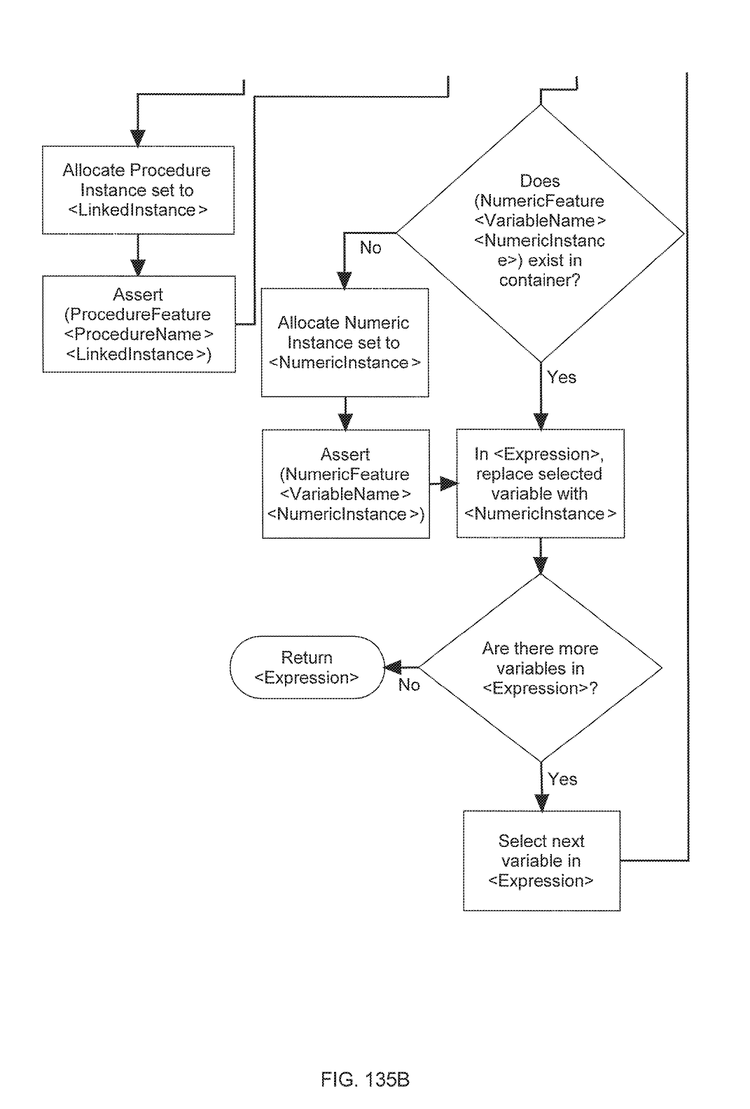

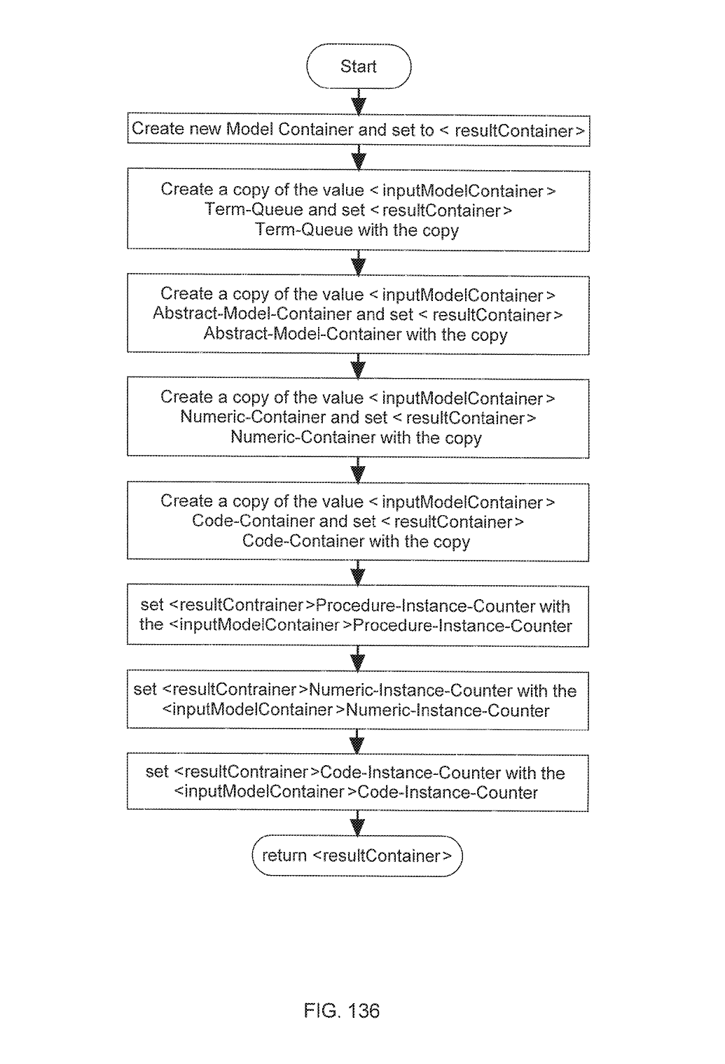

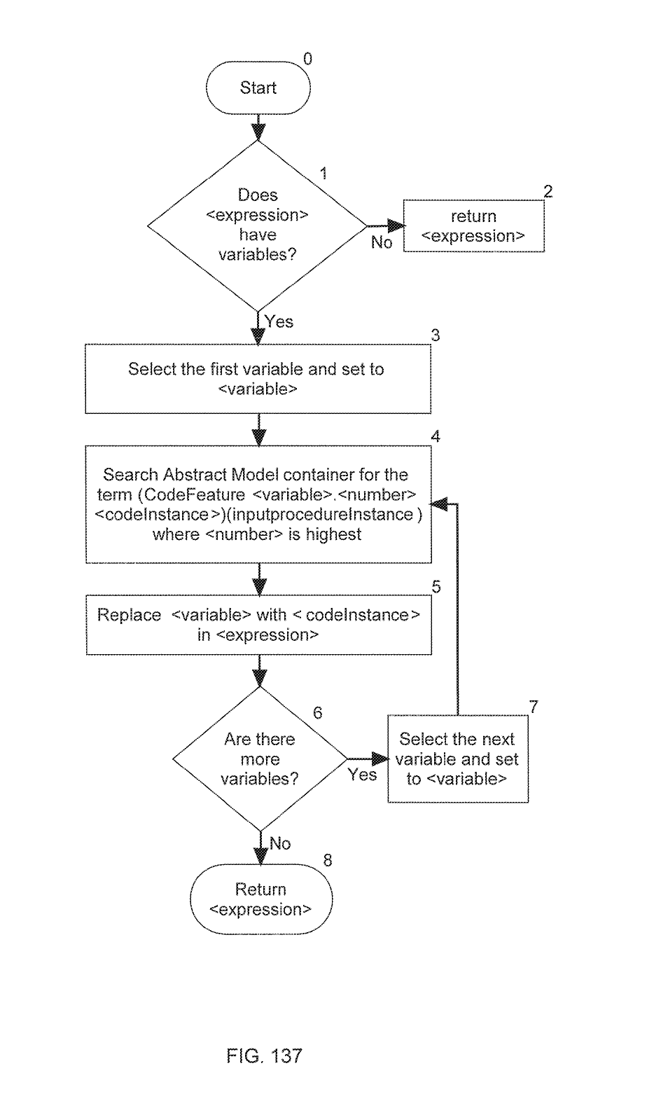

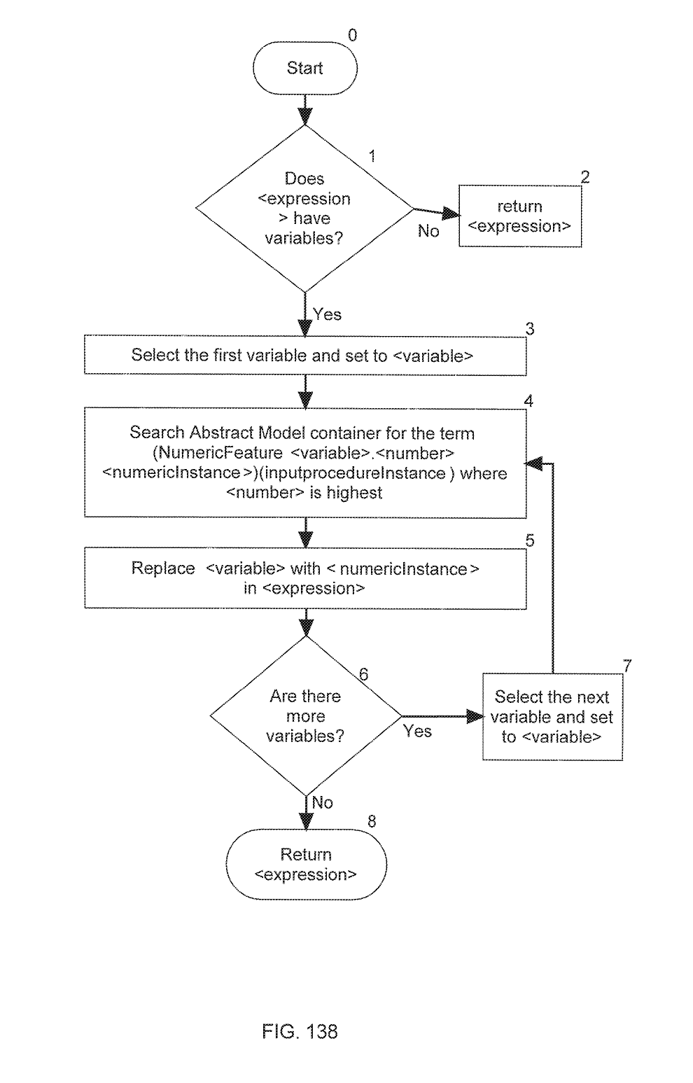

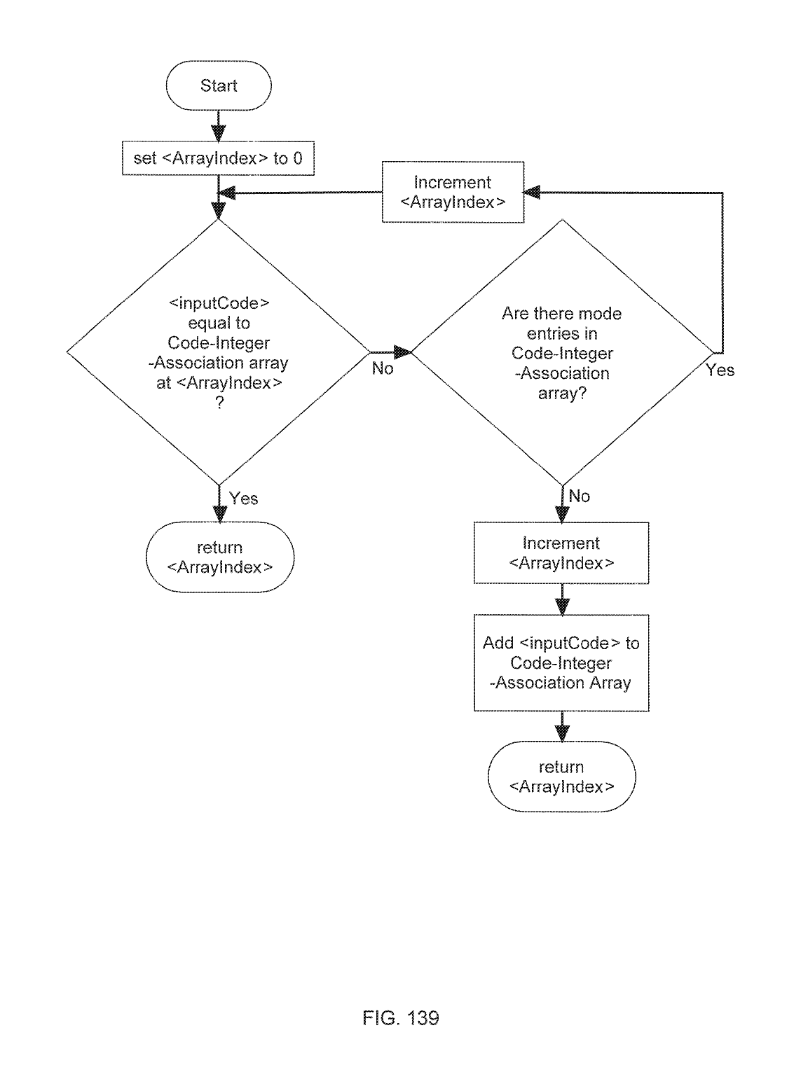

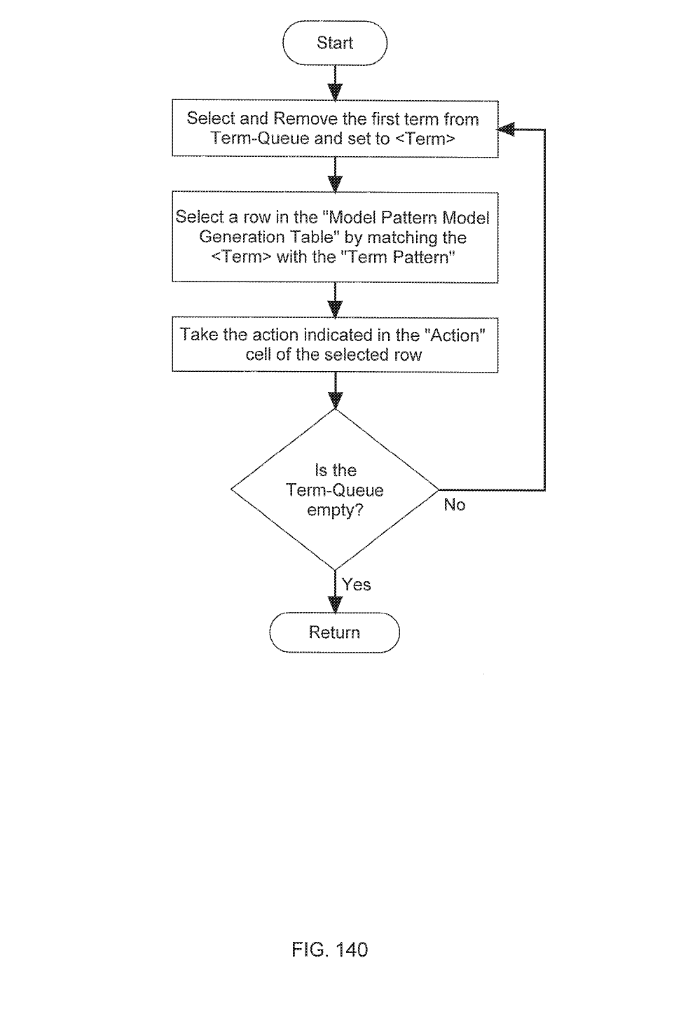

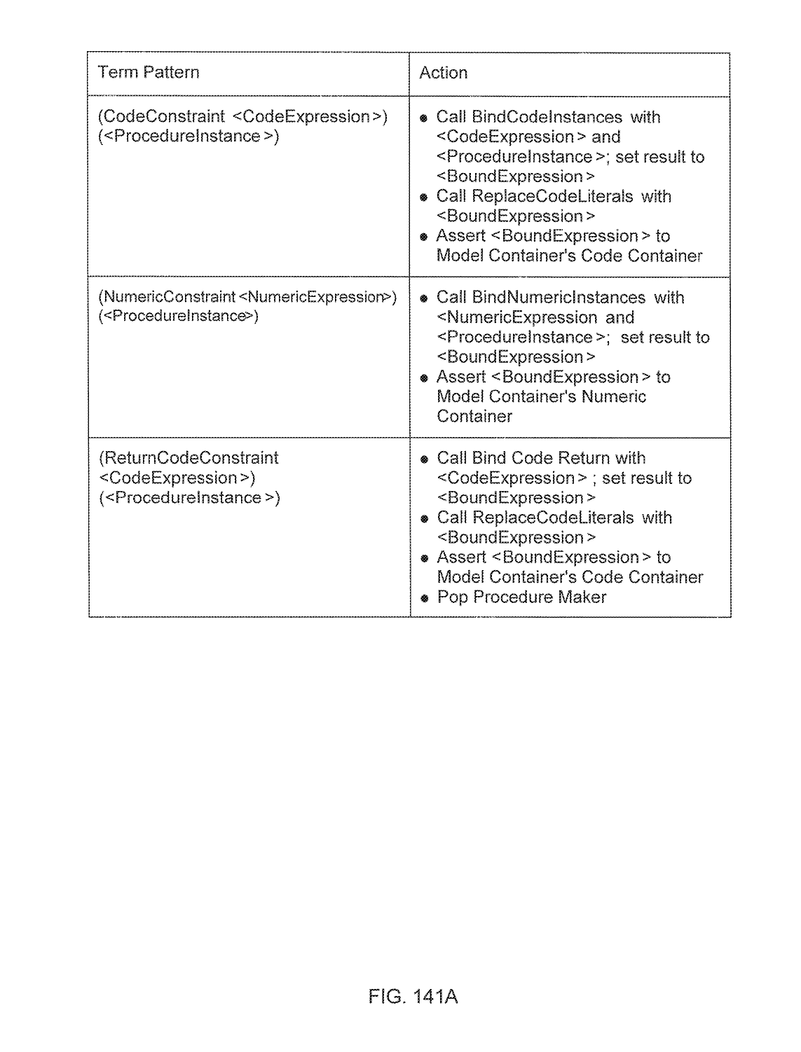

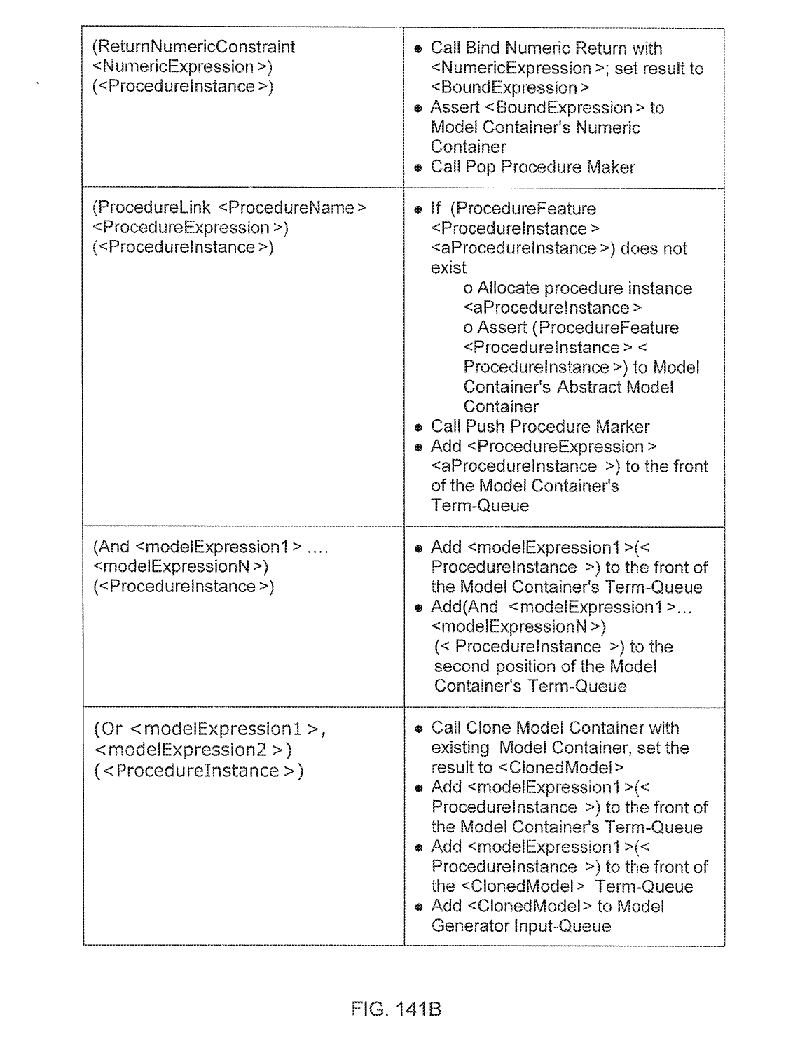

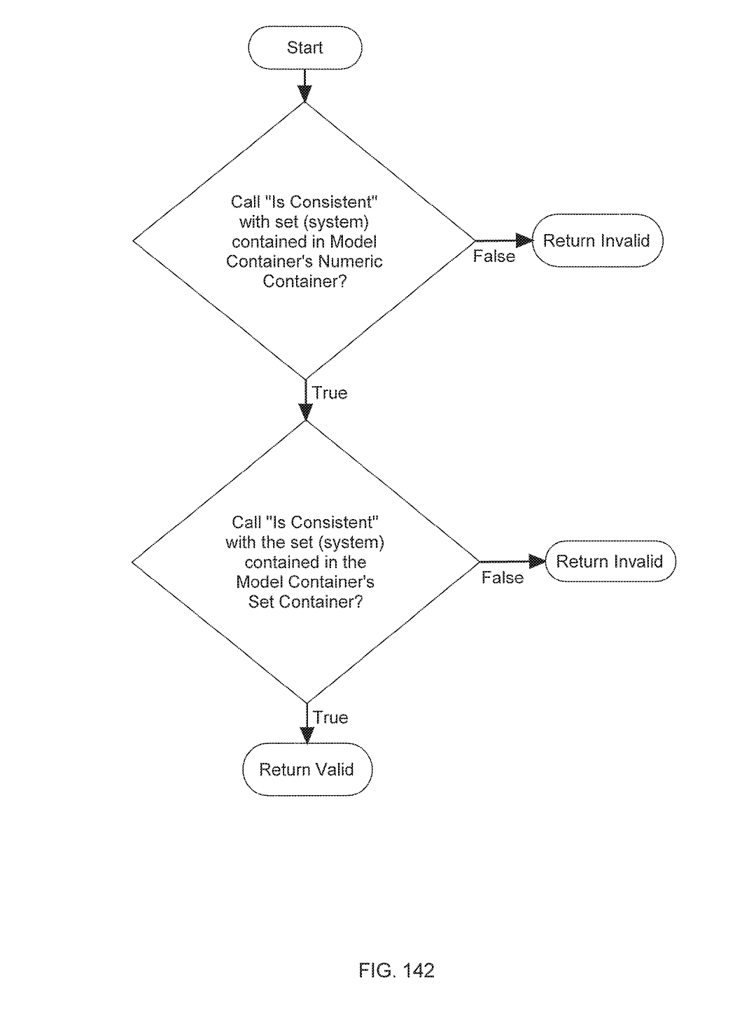

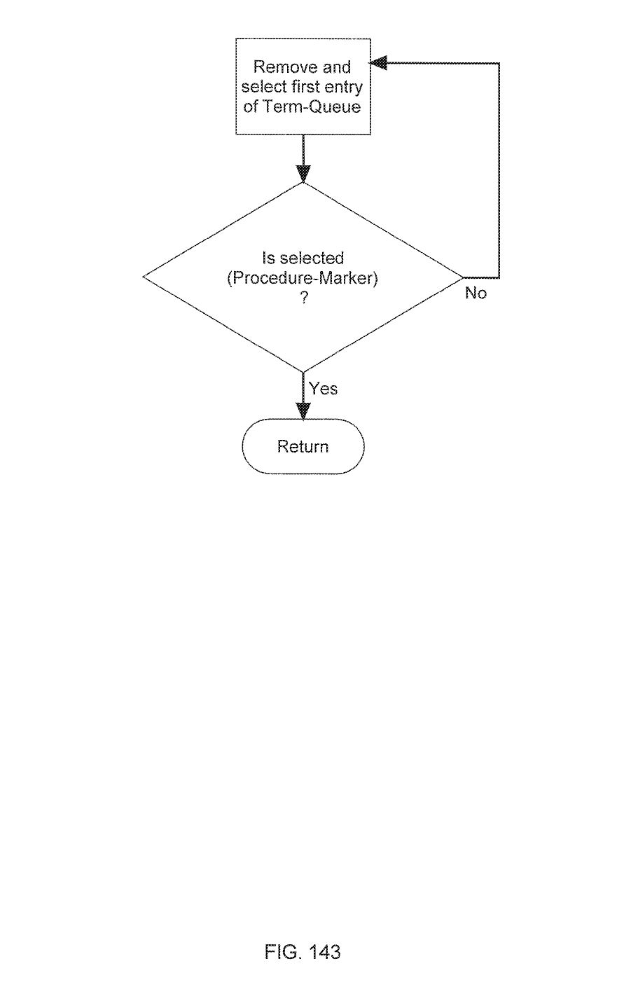

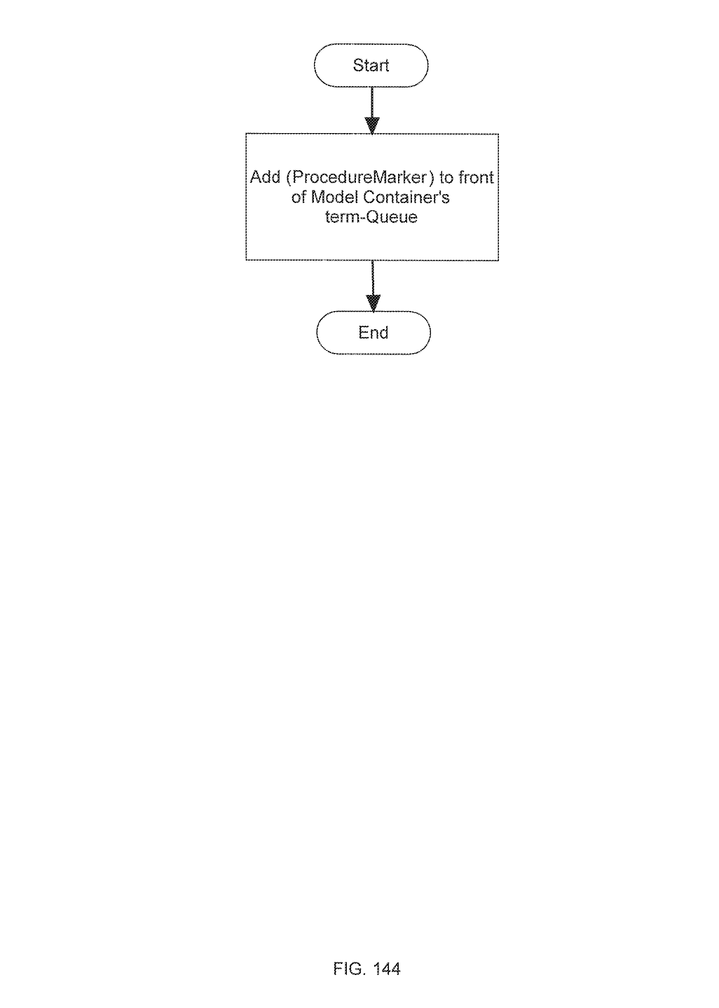

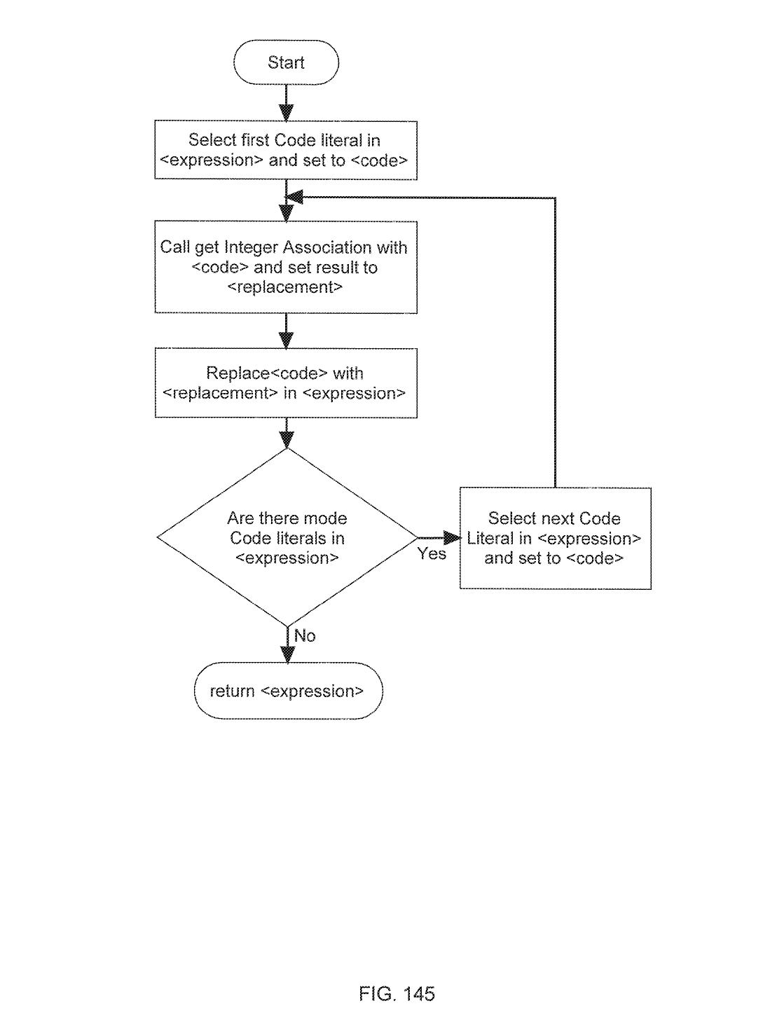

A brief description of the subordinate processes is summarized below. The higher-level relationship of processes to one another is illustrated in FIG. 130.
Allocate Code Instance (FIG. 131) manages the allocation of code instances in the Model Container.
Allocate Numeric Instance (FIG. 132) manages the allocation of numeric instances in the Model Container.
Allocate Procedure Instance (FIG. 133) manages the allocation of procedure instances in the Model Container.
Bind Code Instances (FIGS. 134A-134B) takes an unbound code expression of model logic and binds it to code instances in the Model Container.
Bind Numeric Instances (FIGS. 135A-135B) takes an unbound numeric expression of model logic and binds it to numeric instances in the Model Container.
Clone Model Container (FIG. 136) creates a copy of the Model Container. This is required by the non-determinism introduced by the “Or” operator in model logic (or equivalently, the if-then-else statement operator in the ioExample language).
Bind Code Return (FIG. 137) binds the return variable to the correct variable state data element for code procedures.
Bind Numeric Return (FIG. 138) binds the return variable to the correct variable state data element for numeric procedures.
Tableau Generate All Pattern (FIG. 129) accepts the model expression created by Translation as input and returns a Model Generator as output.
Get Integer Association (FIG. 139) manages the association of Code literals with integers, using Code-Integer-Association array. This facilitates the use of Fourier Elimination for determining the validity of Code model.
Generate Pattern Model (FIG. 140) is the central process of the Tableau. It takes a Model Container whose Term-Queue has been initialized with term representing the Translated system, and continues processing terms until the model is complete. This process uses the pattern model generation table (FIG. 141A-141B) to process the “rules.”
Is Model Valid (FIG. 142) invokes the Fourier Elimination process for both the numeric portion of the model, and the code portion of the model. These in fact determine the validity of the model.
Pop Procedure Marker (FIG. 143) is the second part of model the “return”. Whereas “push” (below) facilitates the removal of program statements by marking where a procedure begins, this process implements the removal when the “return” is hit. It removes any remaining logic statements associated with the procedure in question.
Tableau Push Procedure Marker (FIG. 144) inserts a special marker into the Term Queue to model hitting a “return” statement in ioExample. In essence, it facilitates the removal all further program operators that are associated with the current procedure when a “return” is encountered.
Replace Code Literals (FIG. 145) replaces code literals with integers such that the Code Data Type can be validated by Fourier Elimination (discussed above). It uses the Model Containers Code-Integer-Association-Array to maintain a one-to-one association between integers and unique code literals.

Example

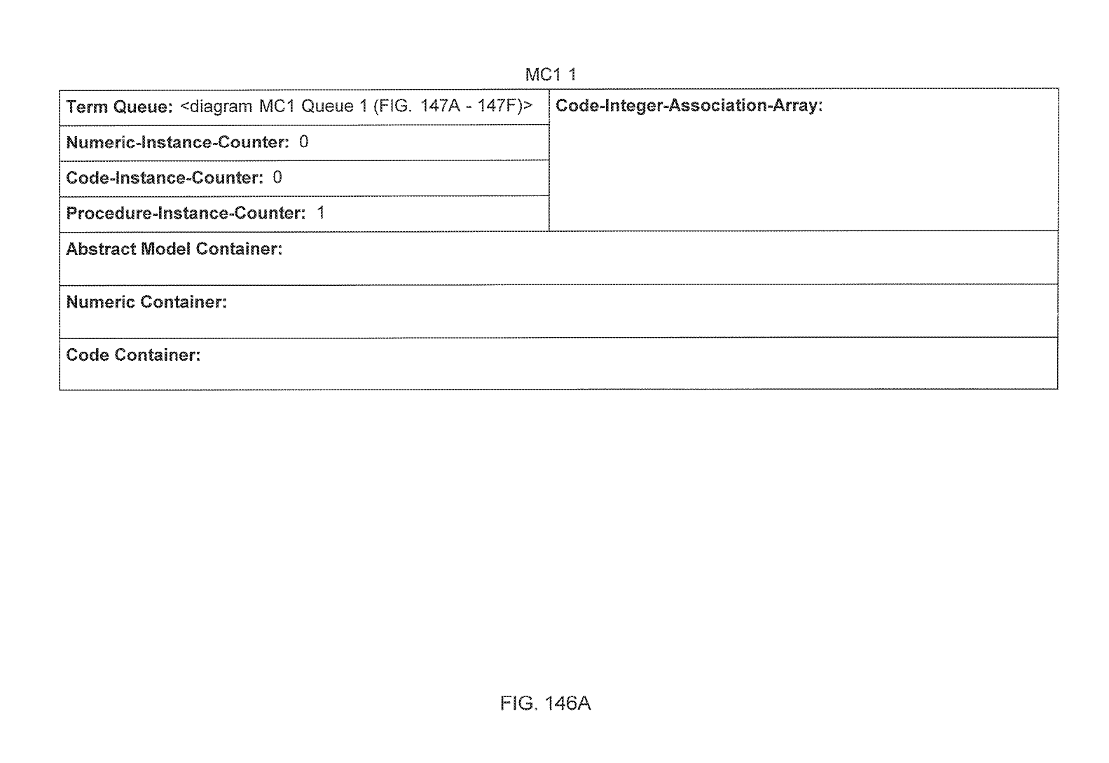

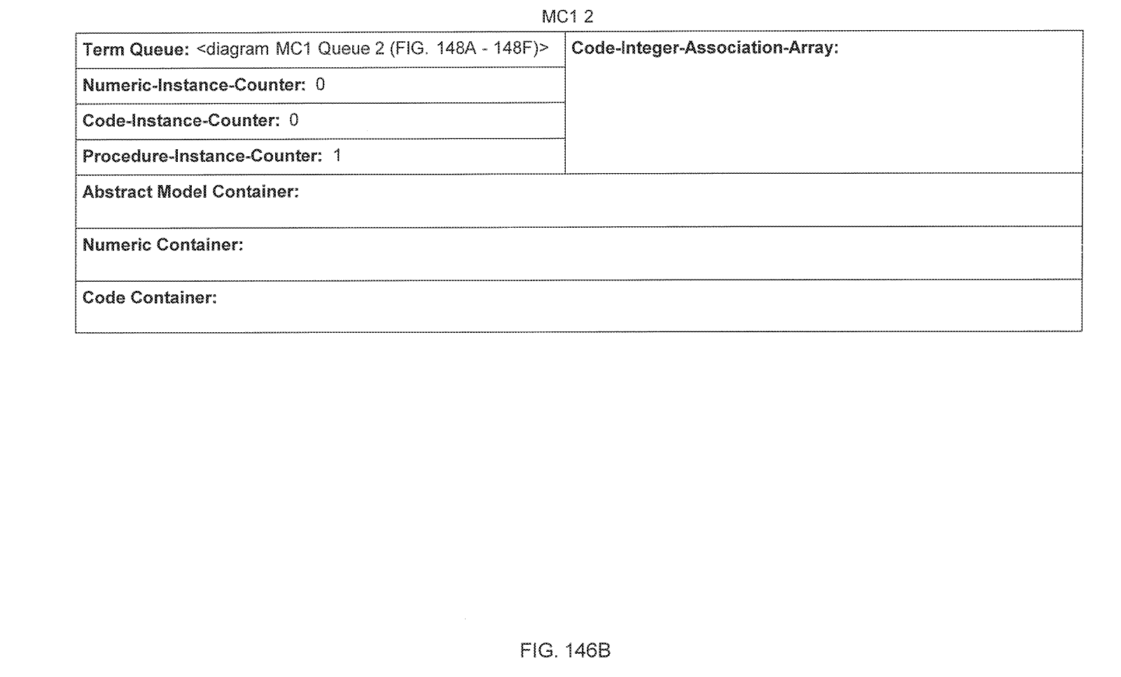

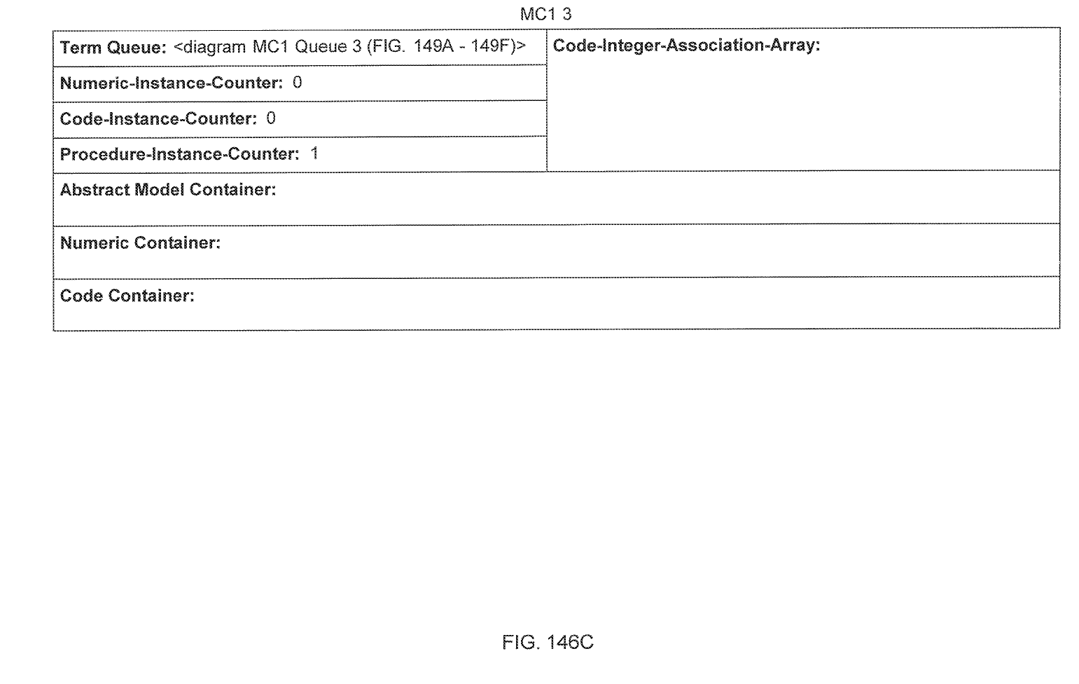

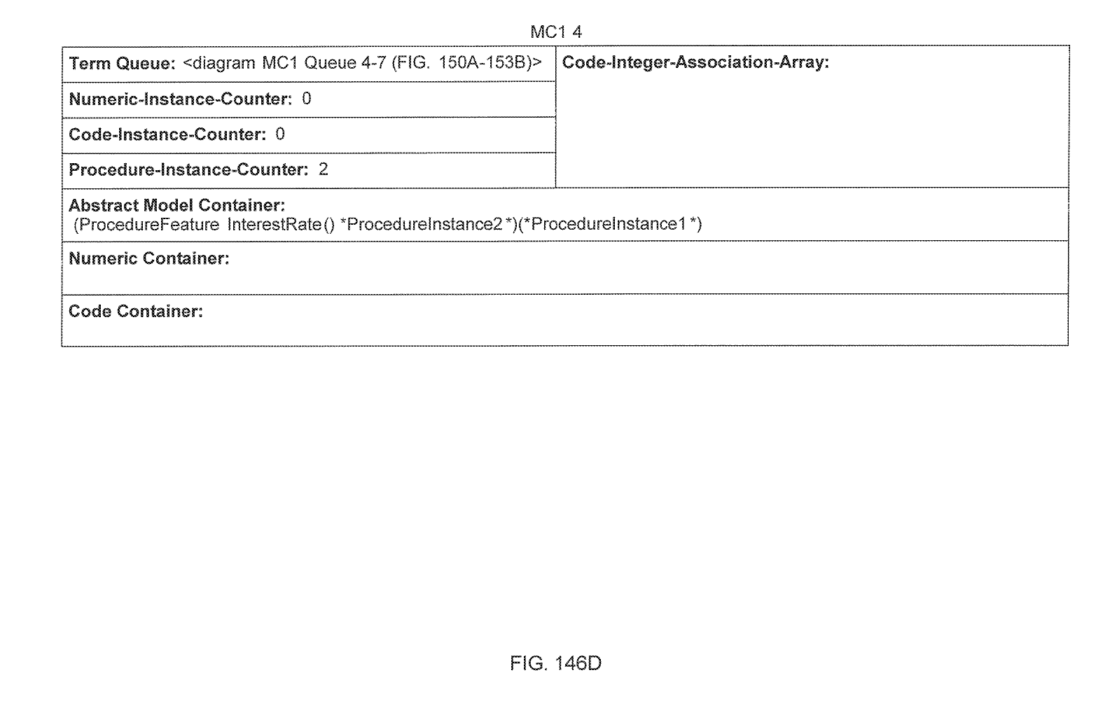

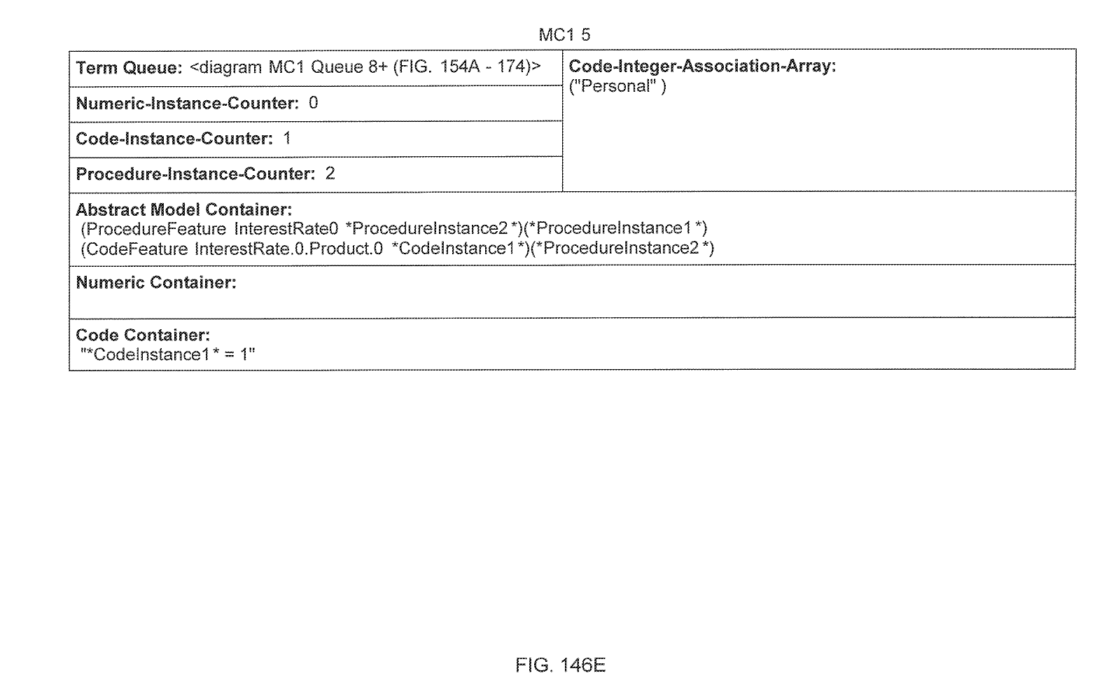

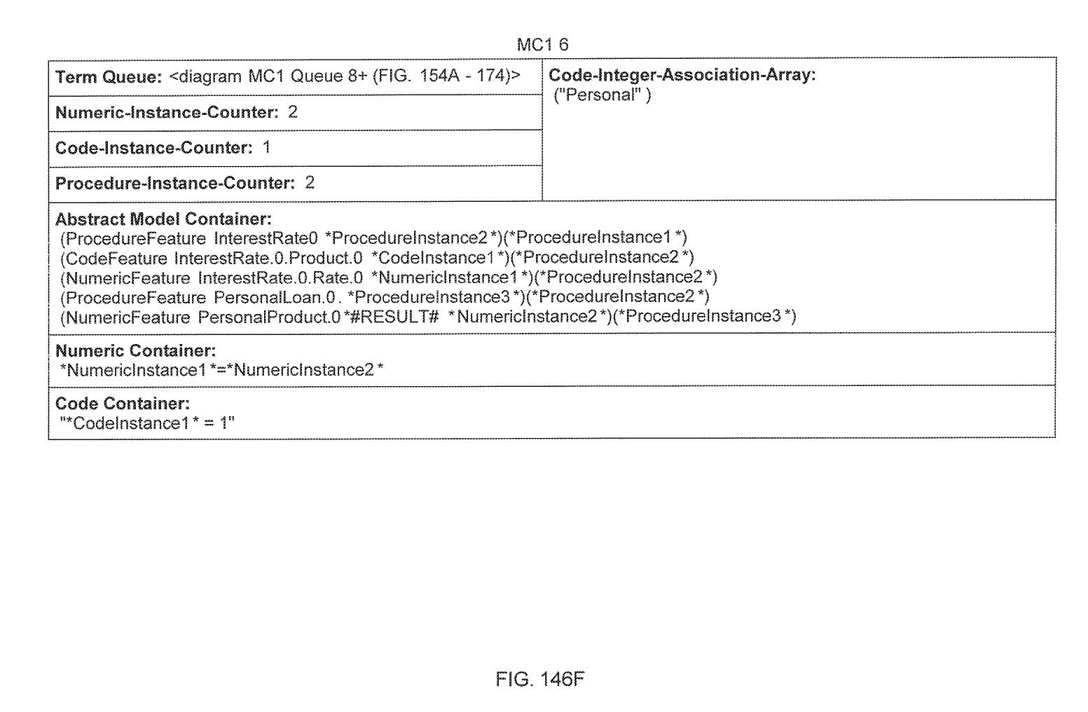

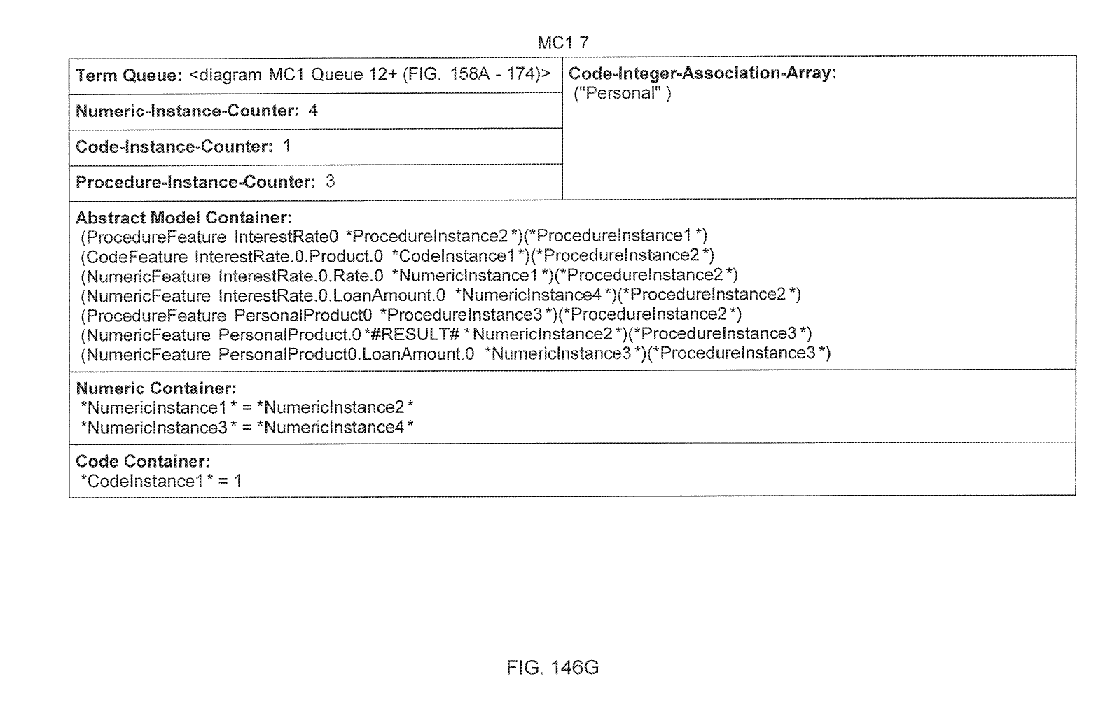

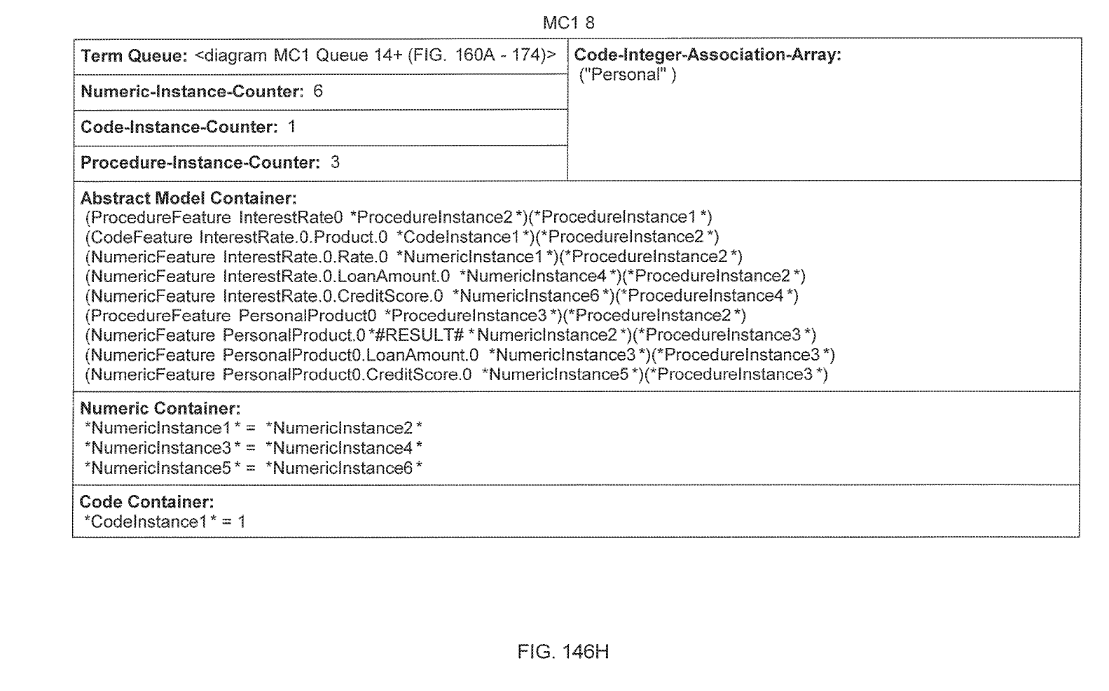

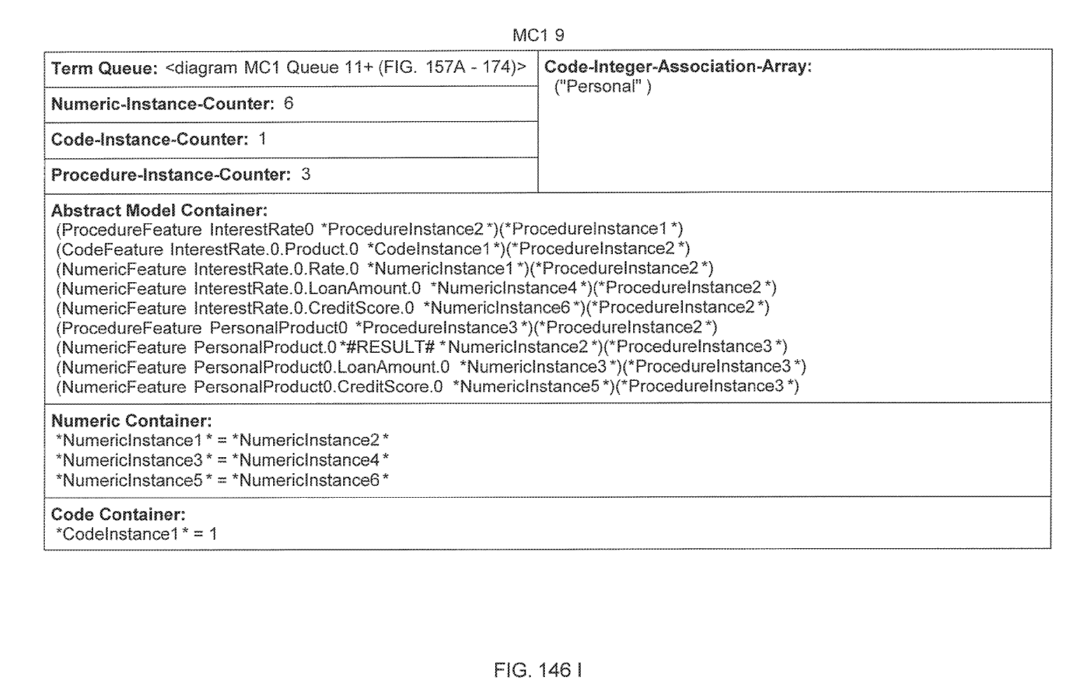

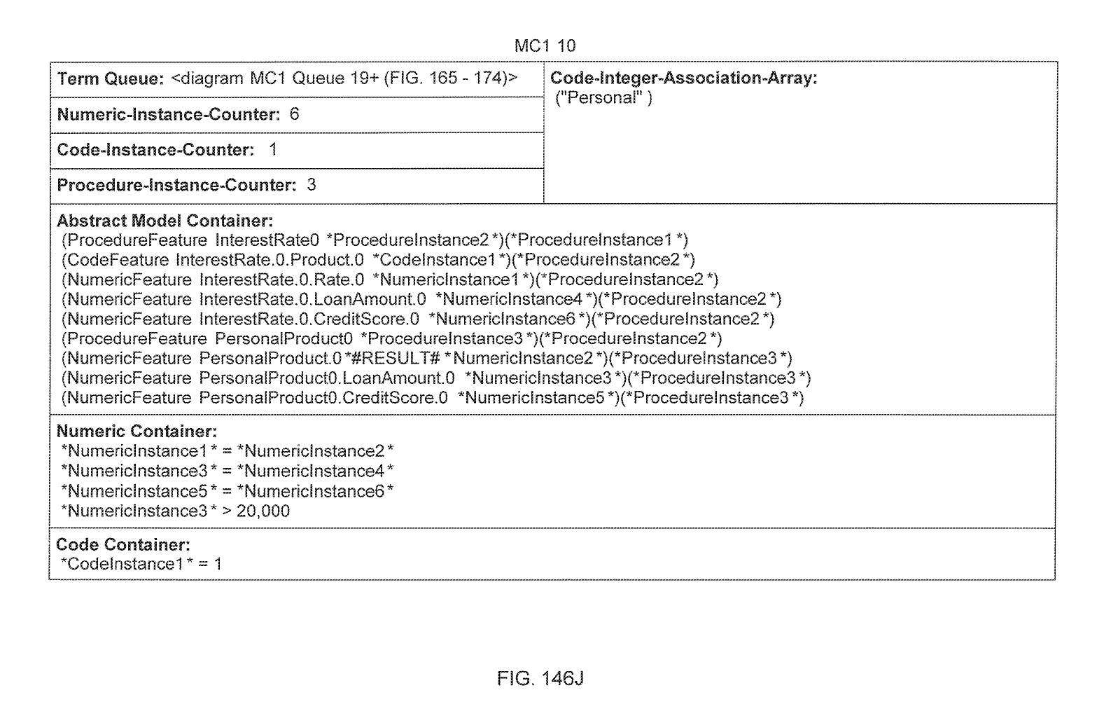

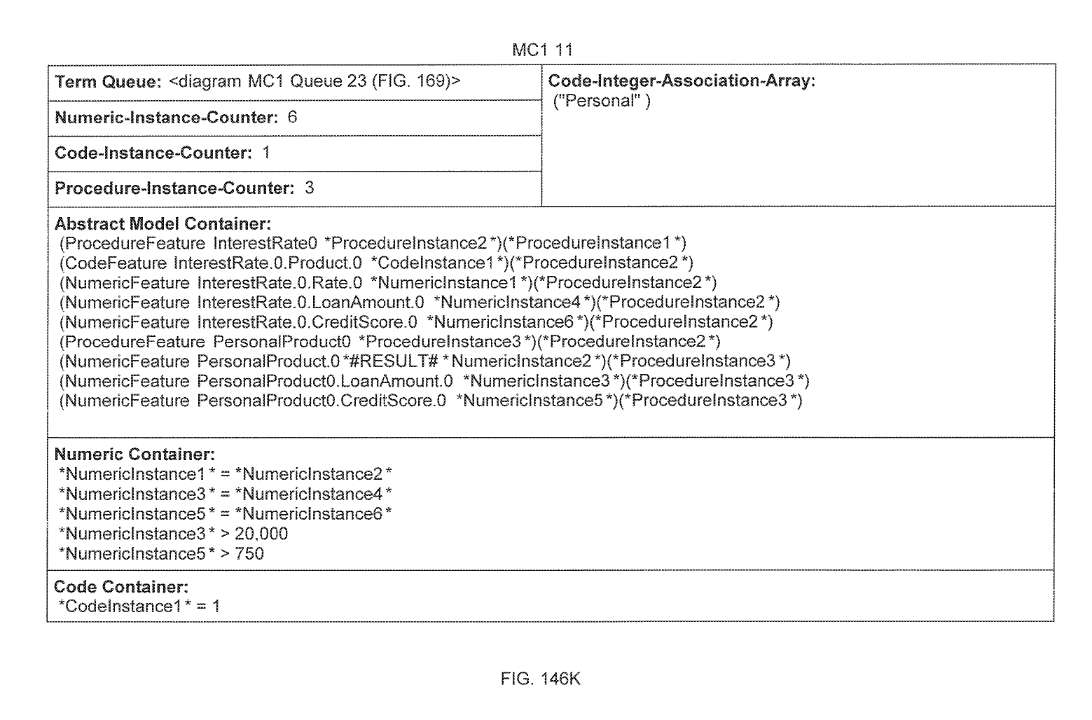

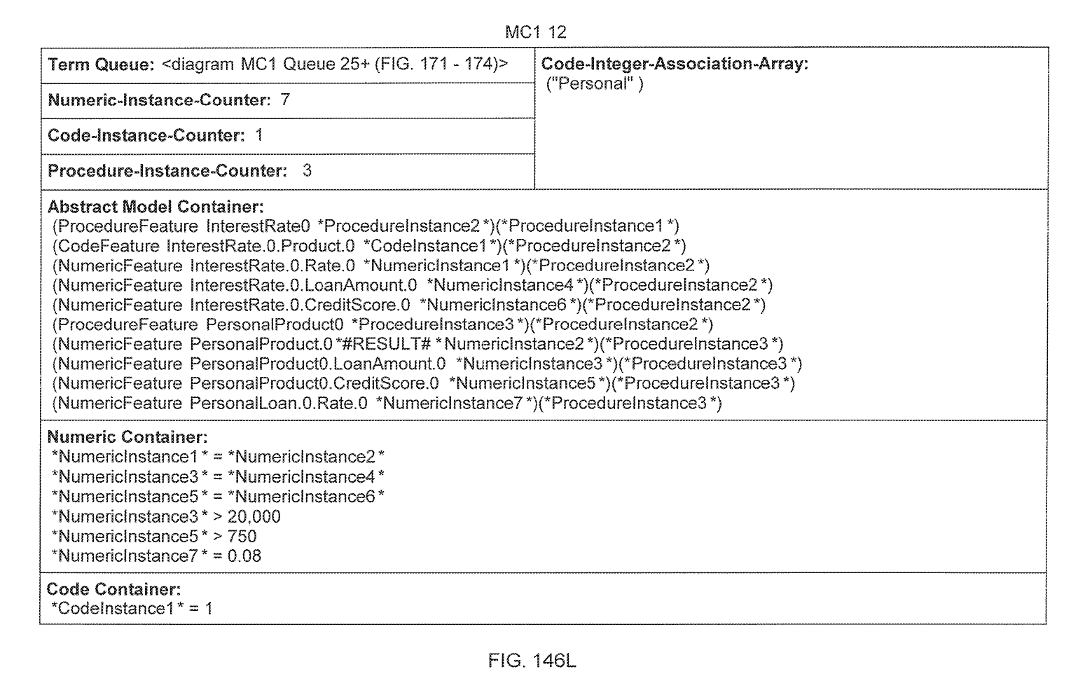

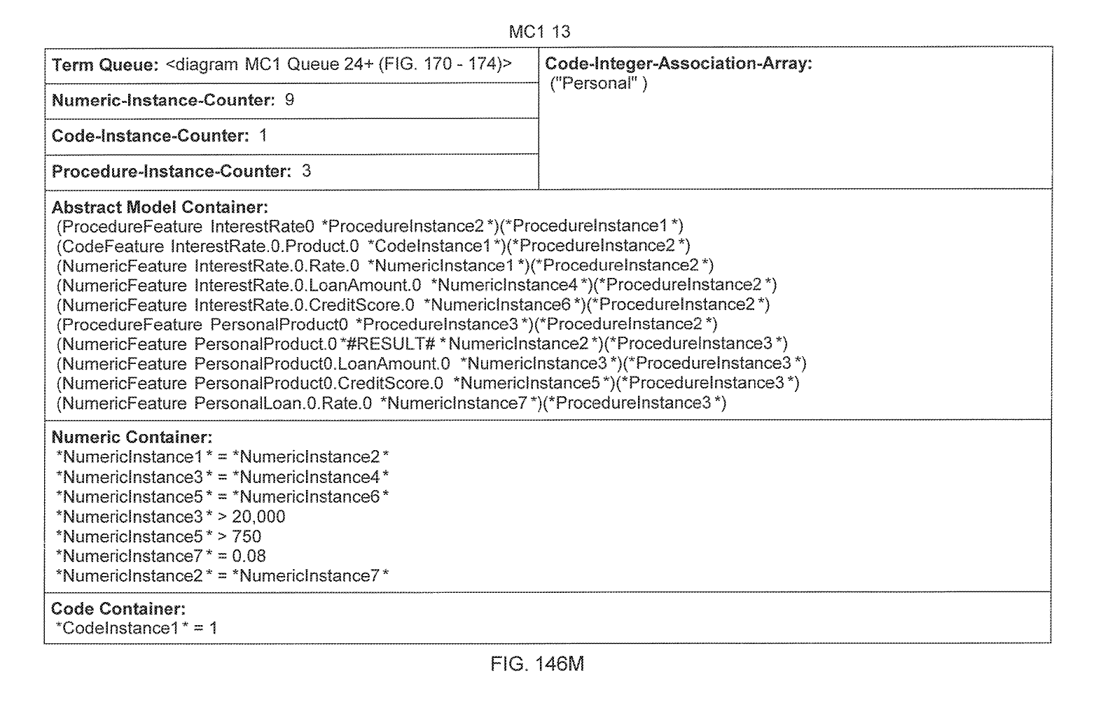

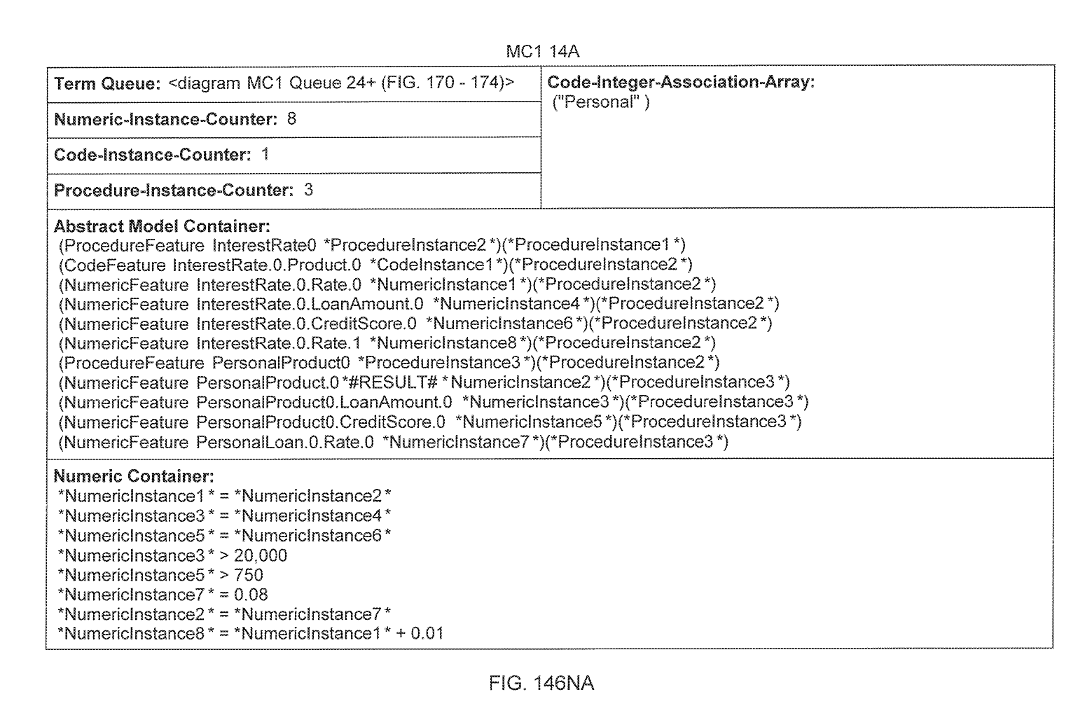

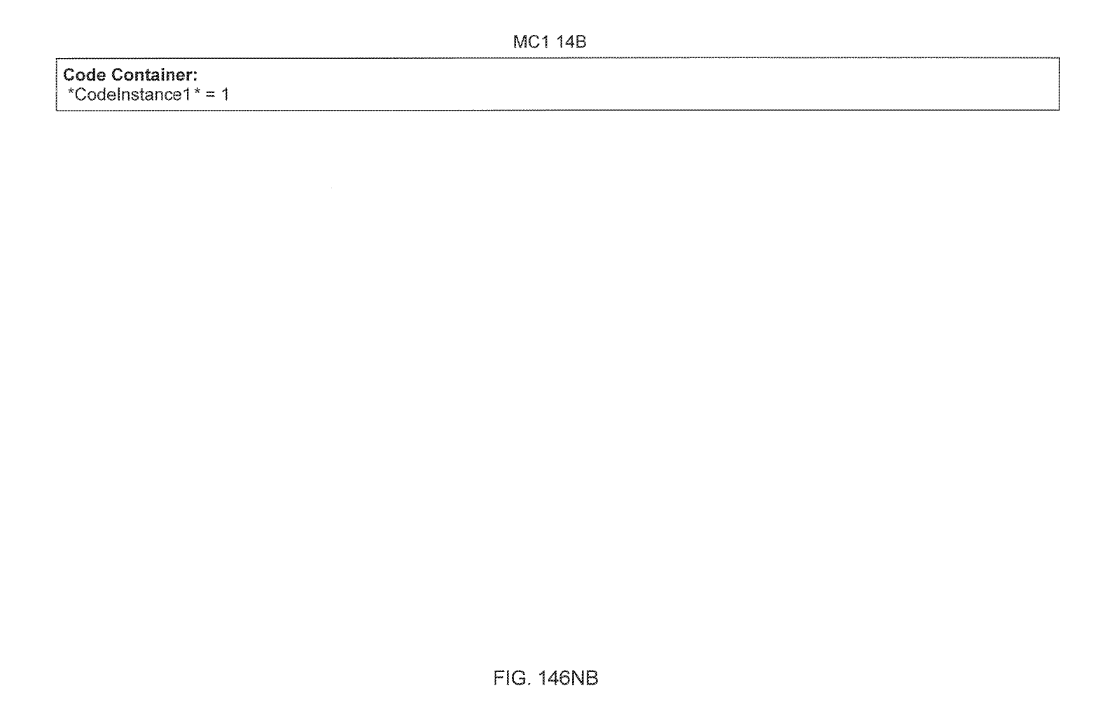

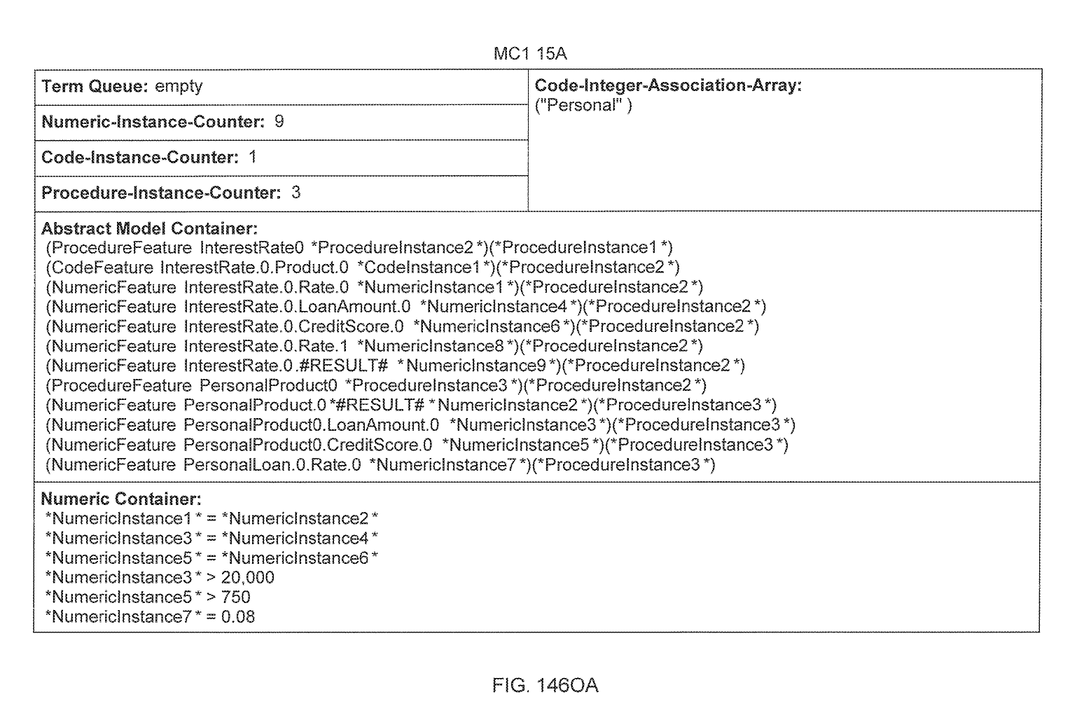

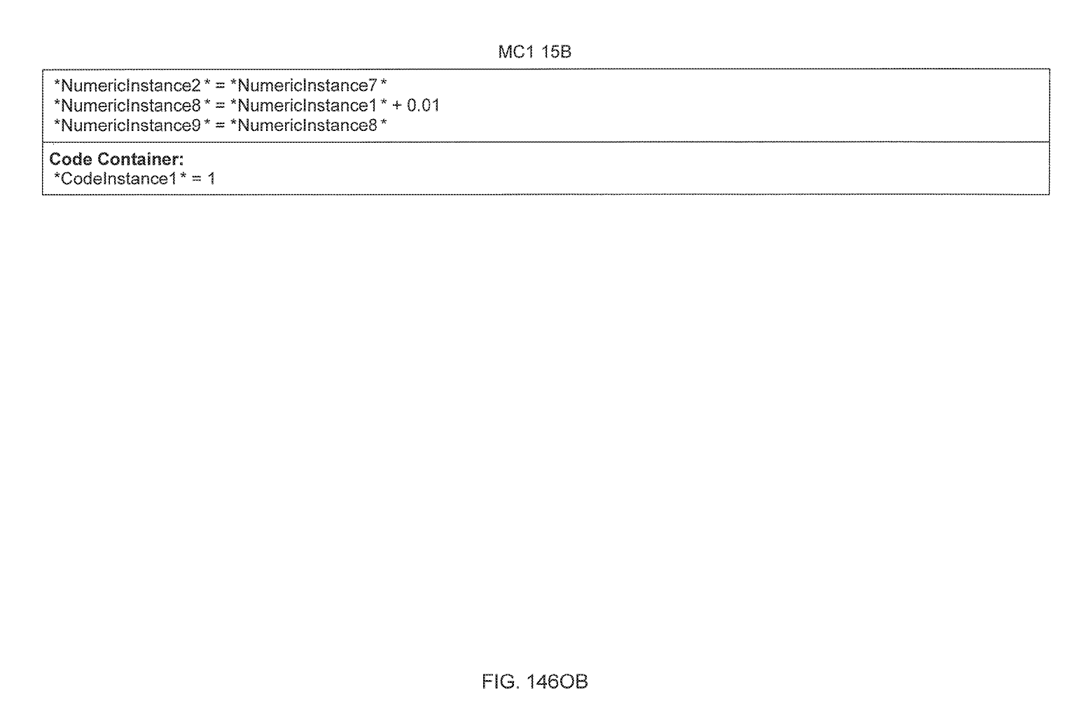

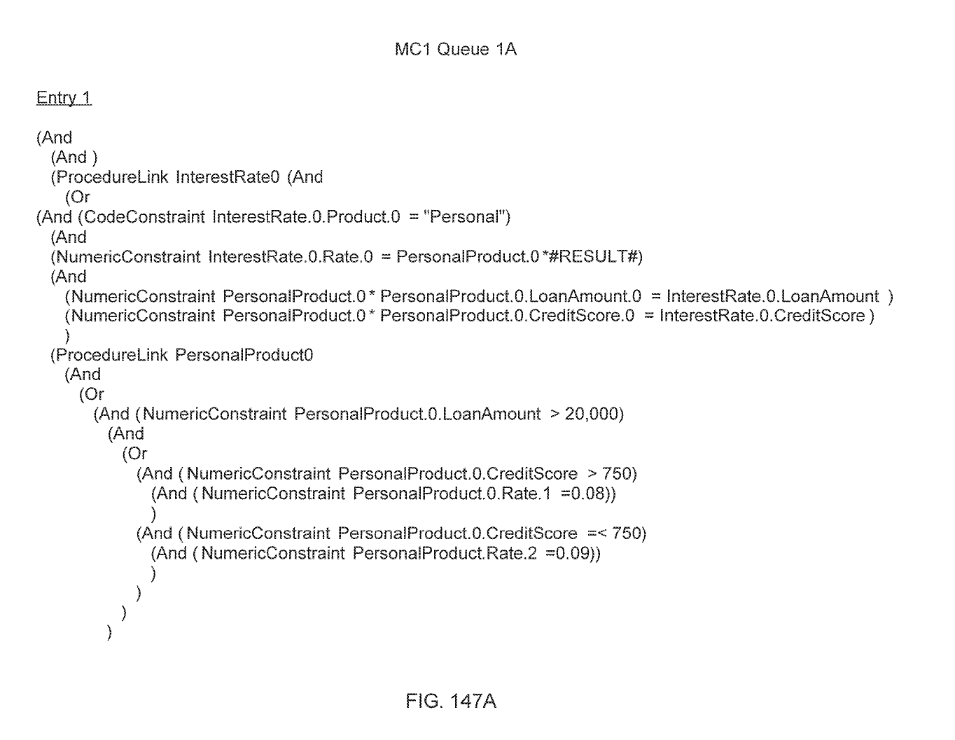

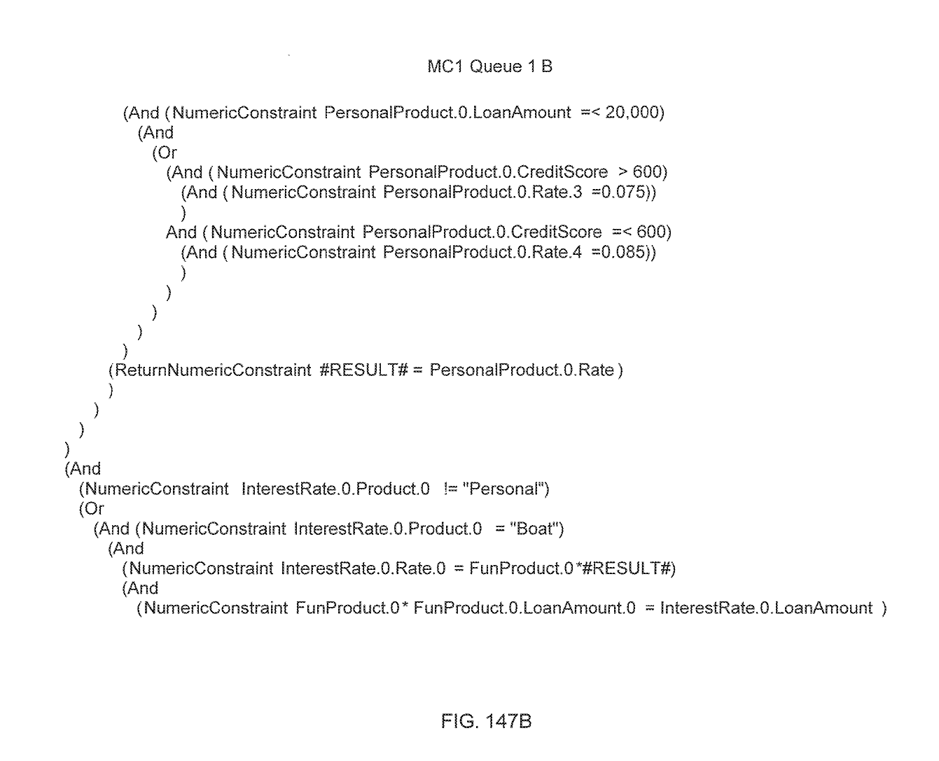

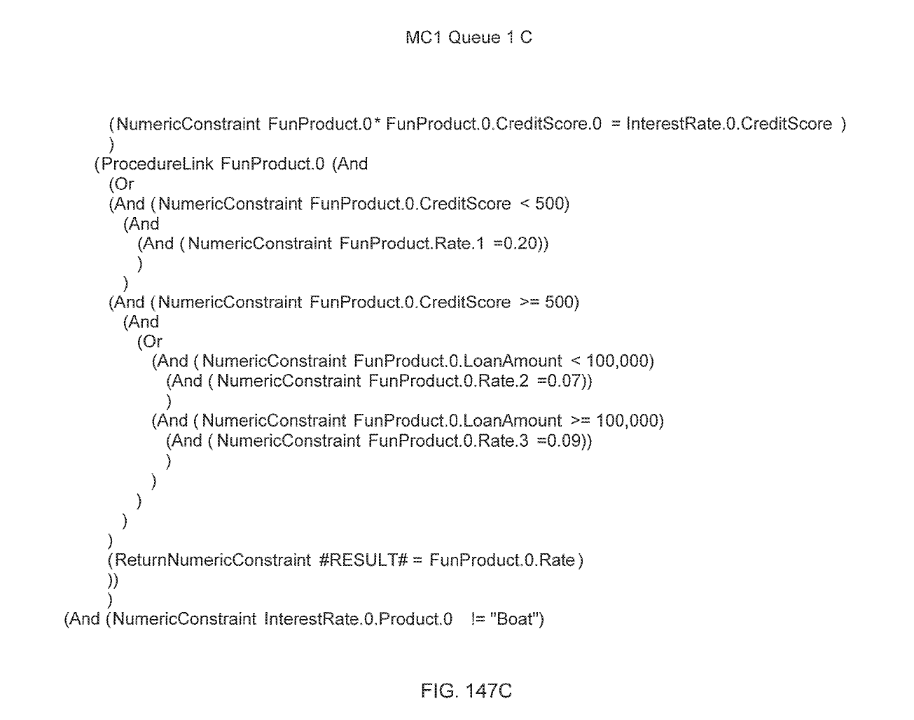

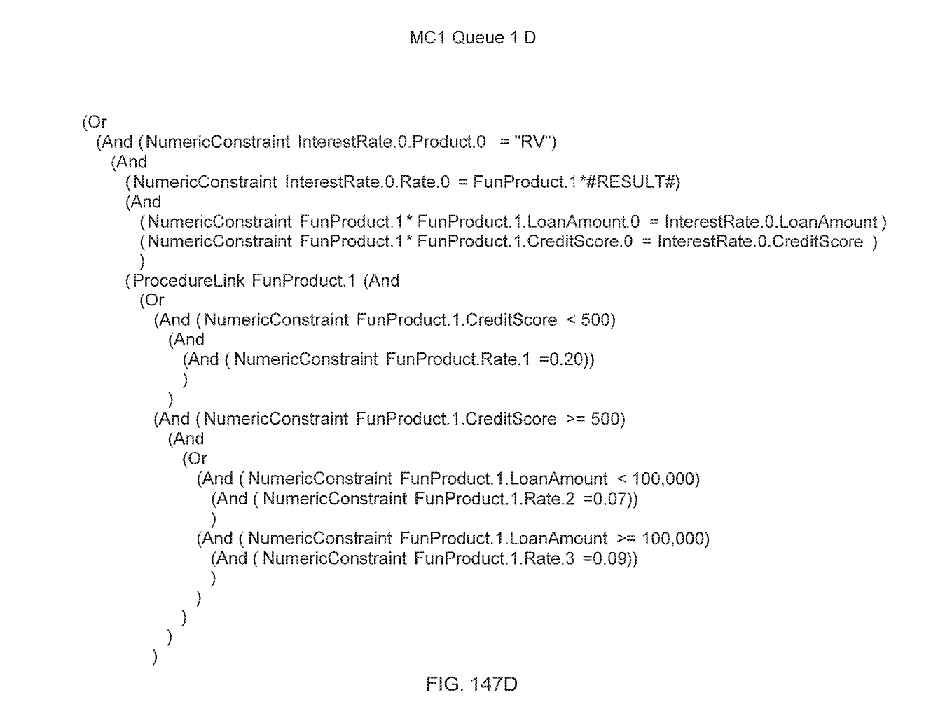

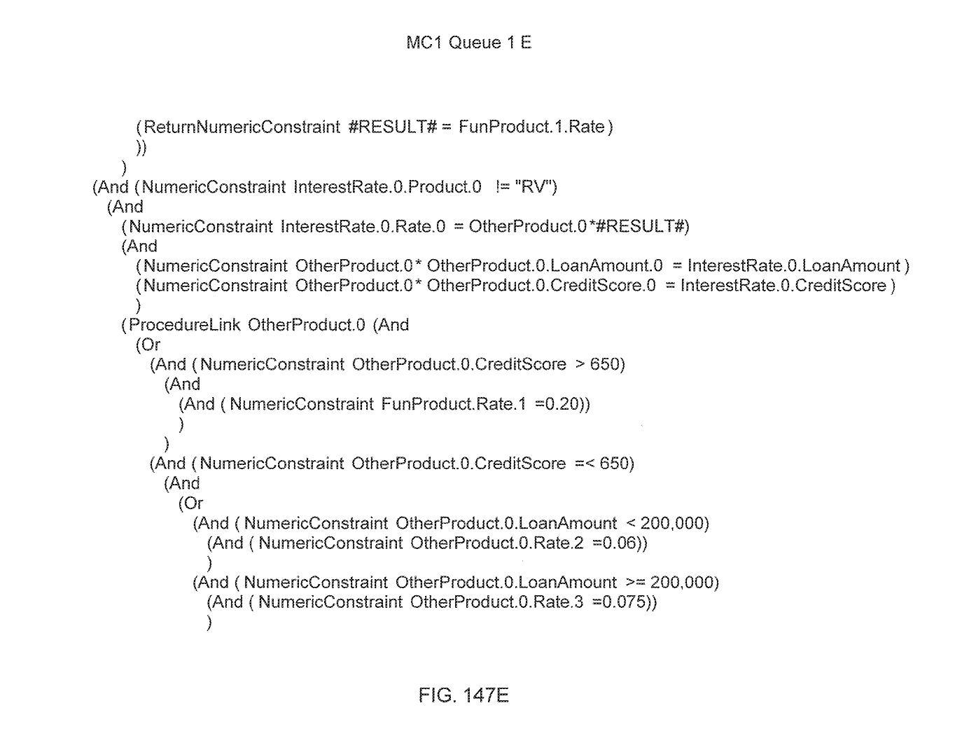

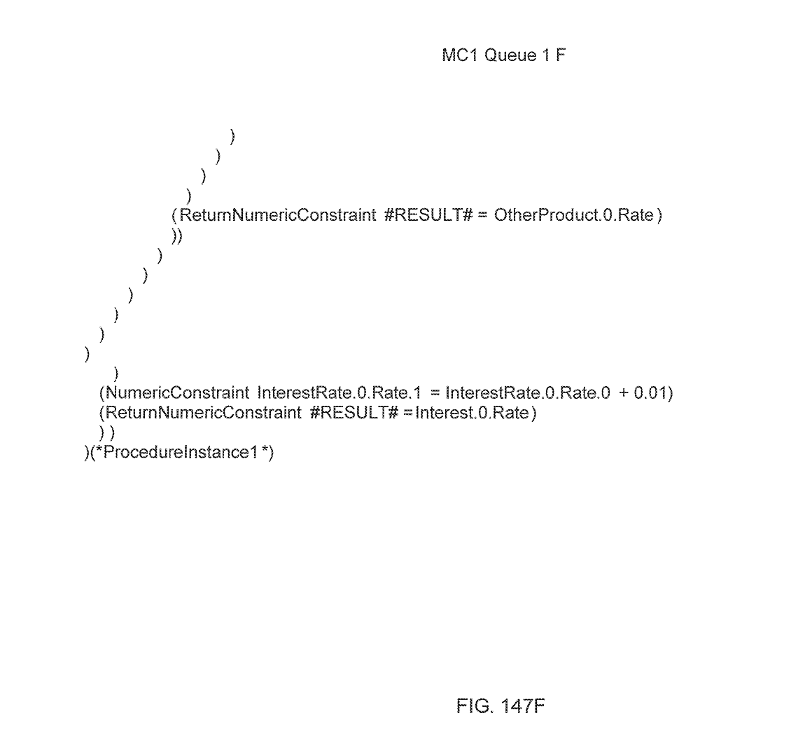

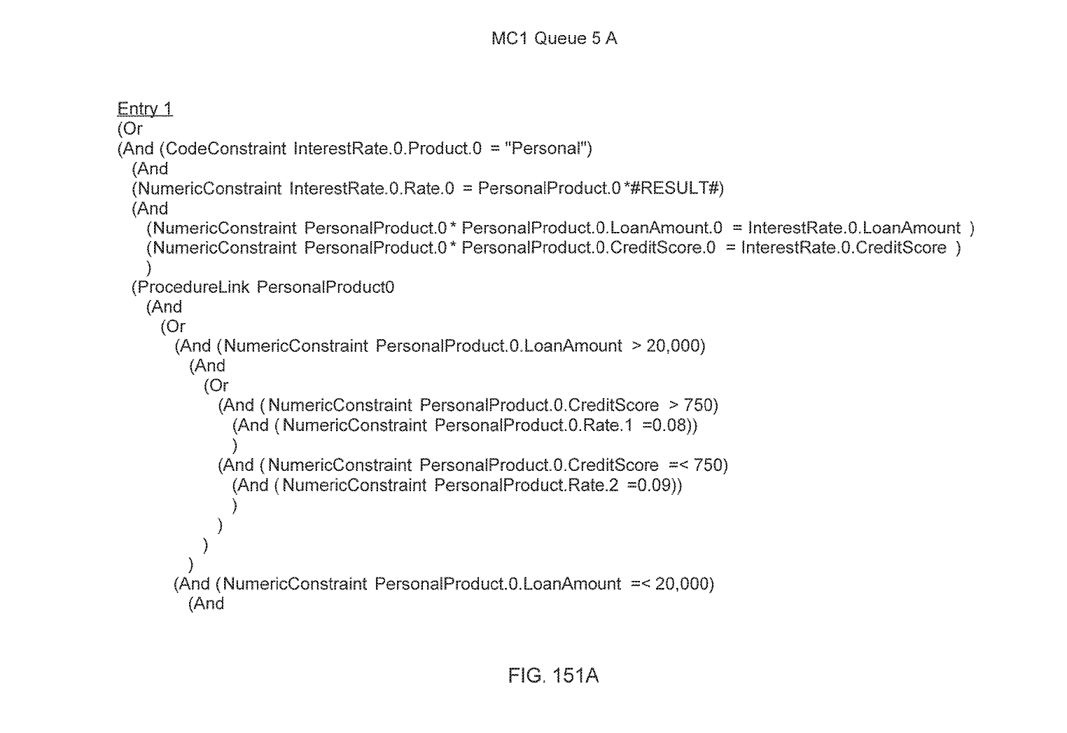

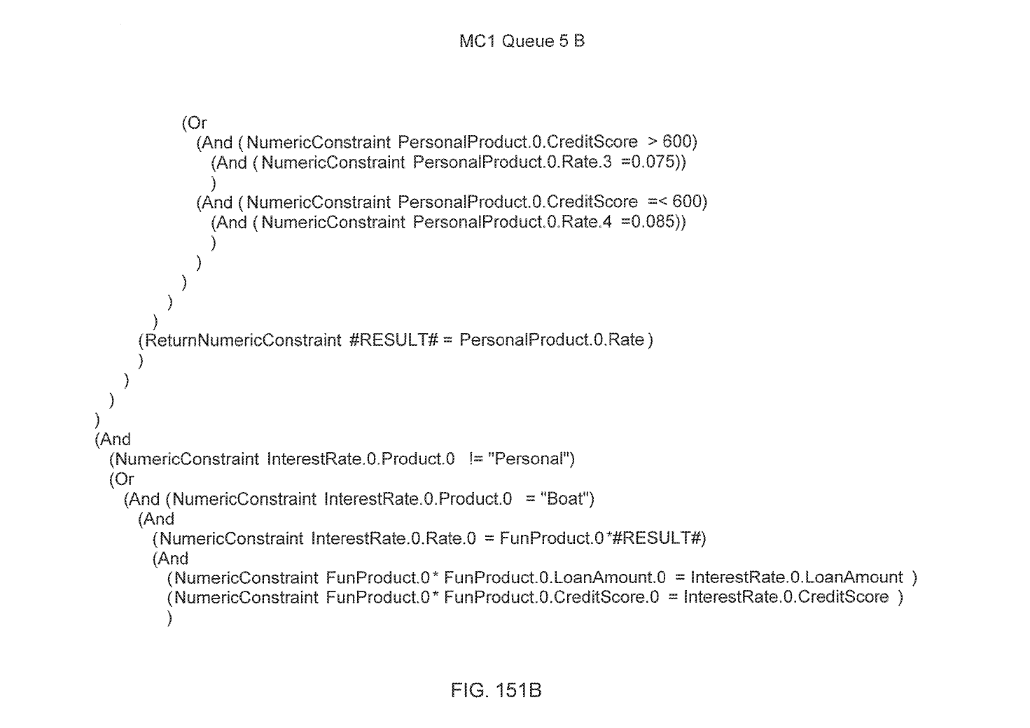

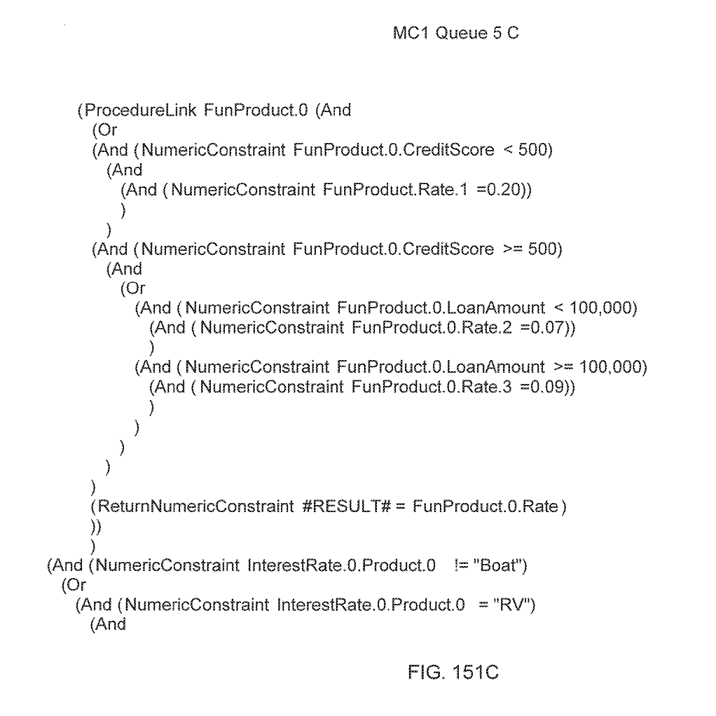

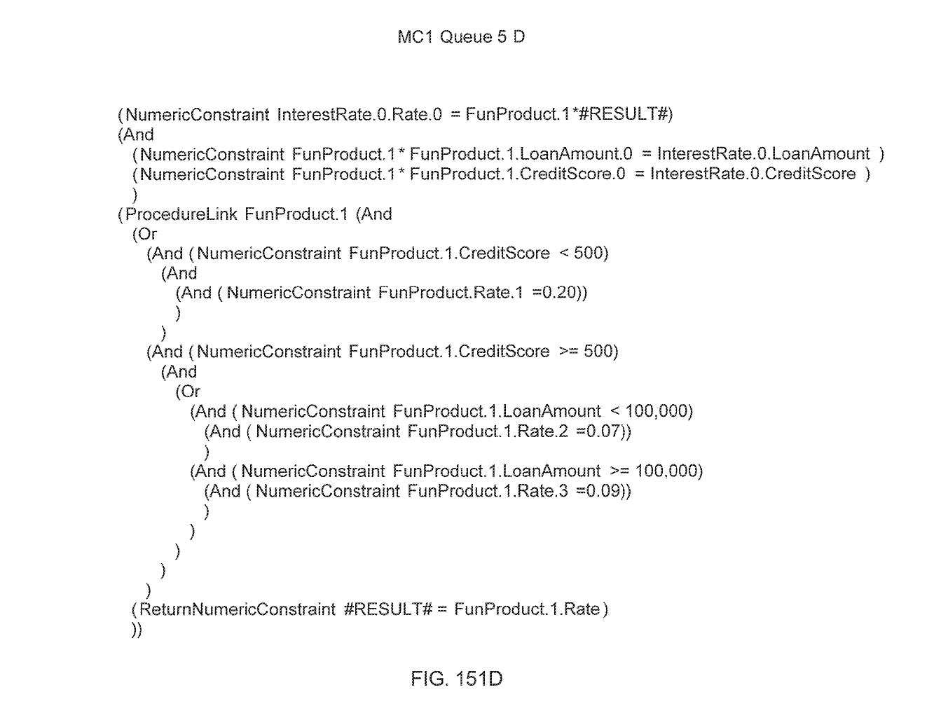

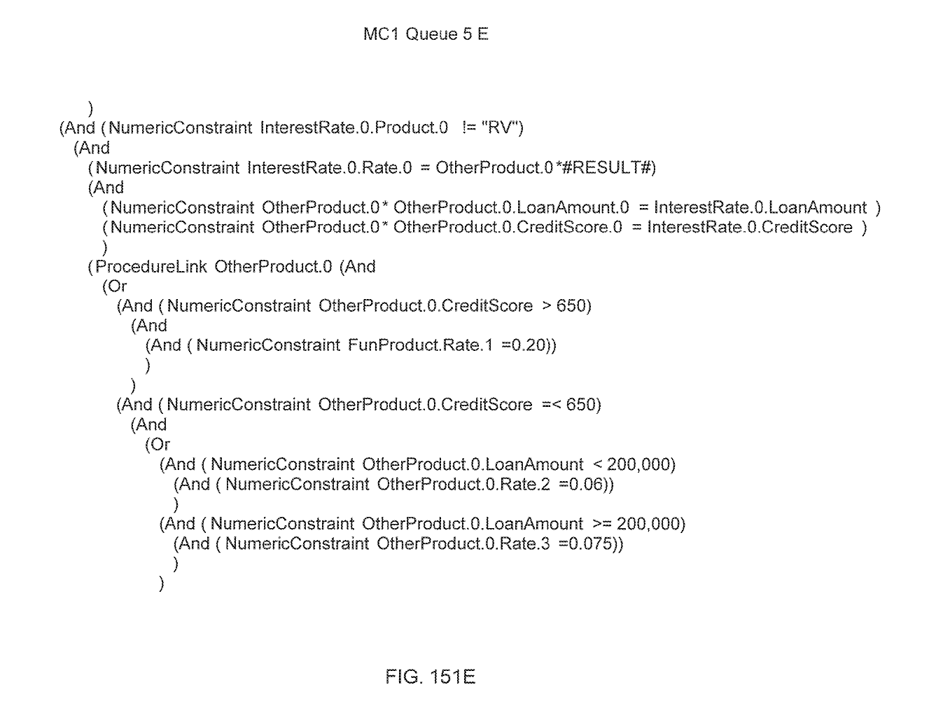

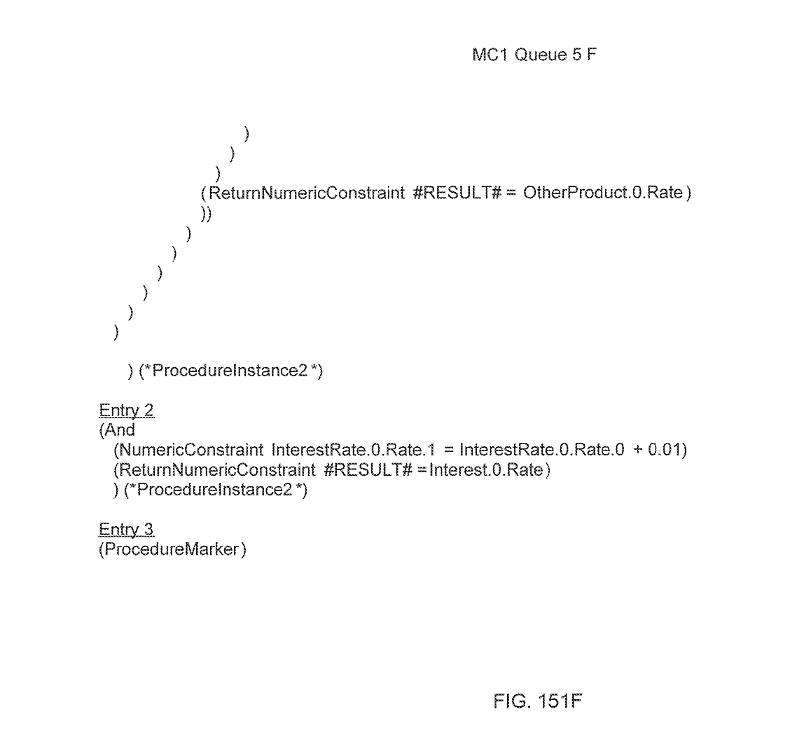

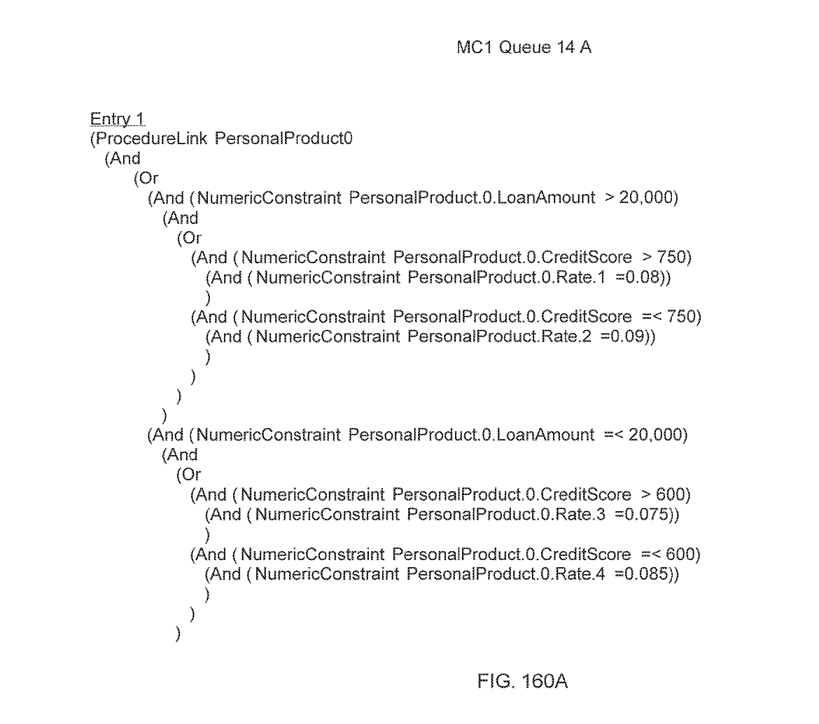

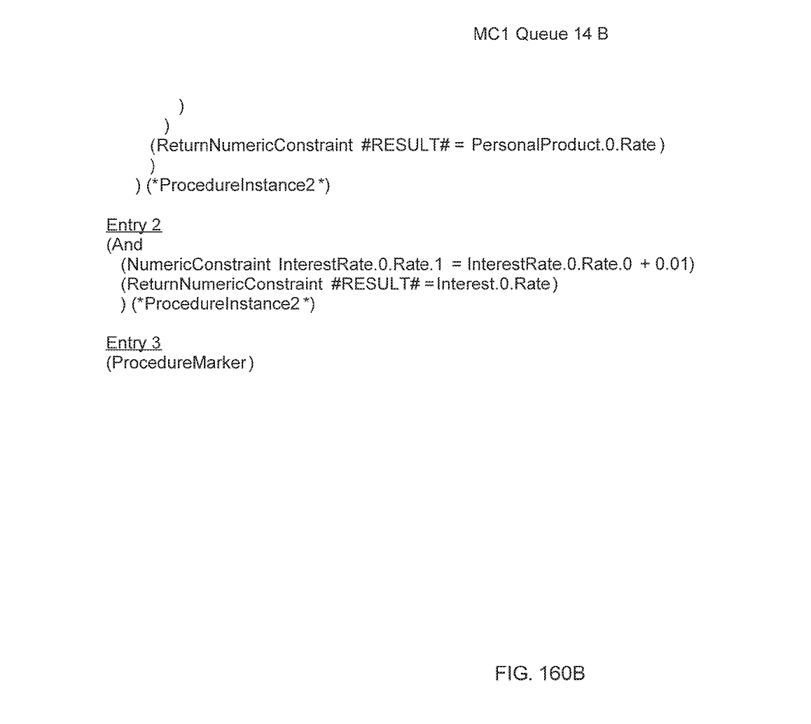

The example that follows shows in detail the Tableau process in action for one model pattern that results from the Interest Rate system. The example also shows the results for all remaining model patterns corresponding to the FIOSM. The example uses a variety of diagrams to illustrate. The “Model Container MC#” diagrams (FIGS. 146-146OB, 175, 176B, 178-179B, 181-182B, 184-192B) show the state of Model Container as the processes modify it. The only exception to Model Container data not shown in these diagrams is the Term Queue. These data structures are typically large enough that their expressions do not fit legibly into such a block diagram. The Term-Queues are contained in separate diagrams in the form MC# Queue # (FIGS. 147A-174, 177A-177E, 180, 183). These are referred to, from within the Model Container diagrams.

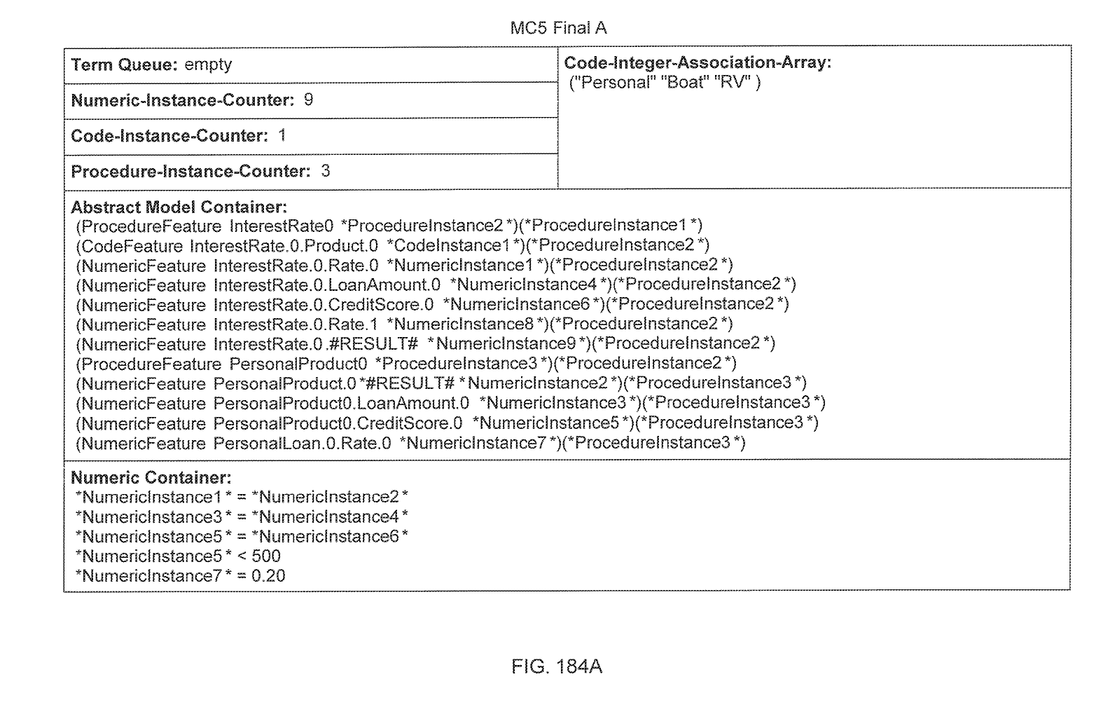

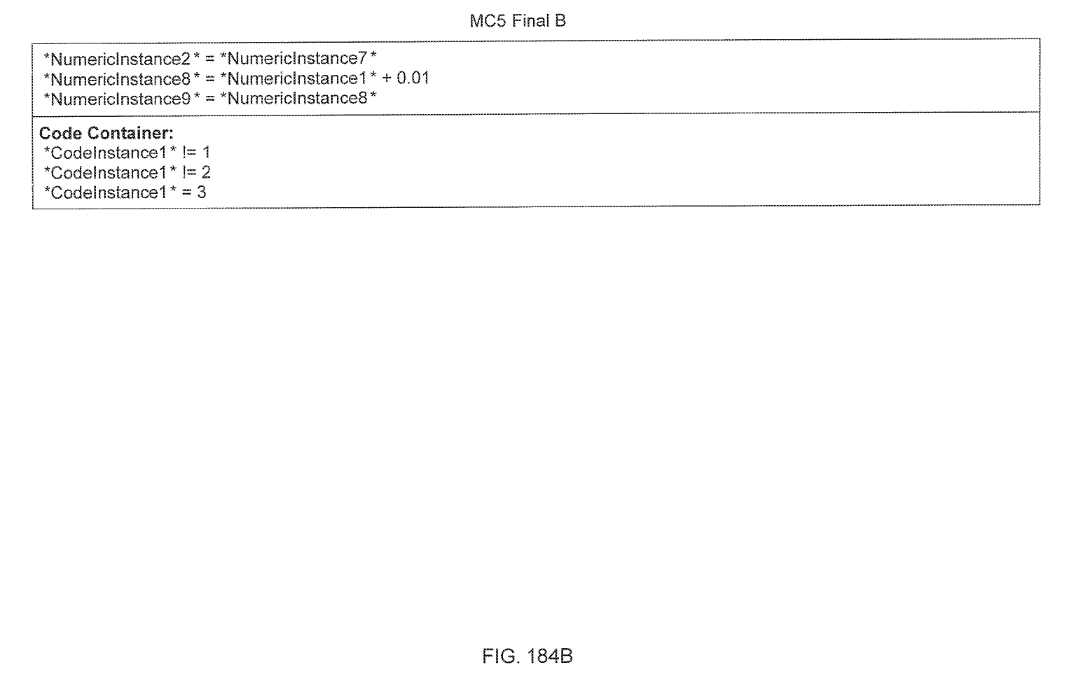

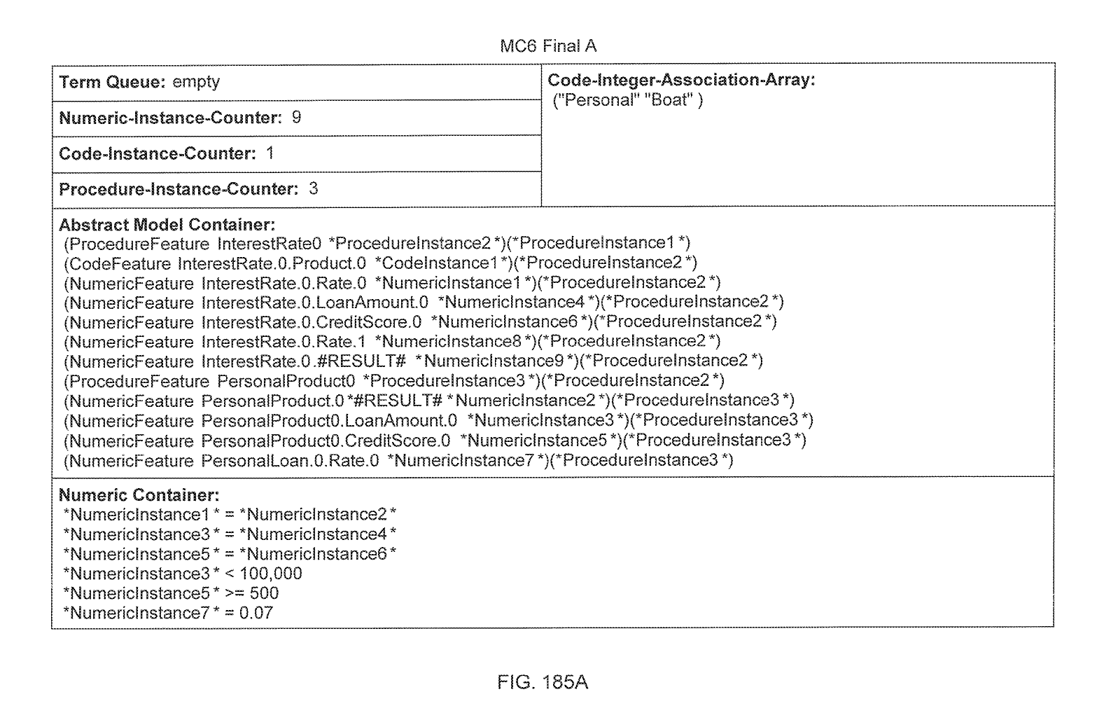

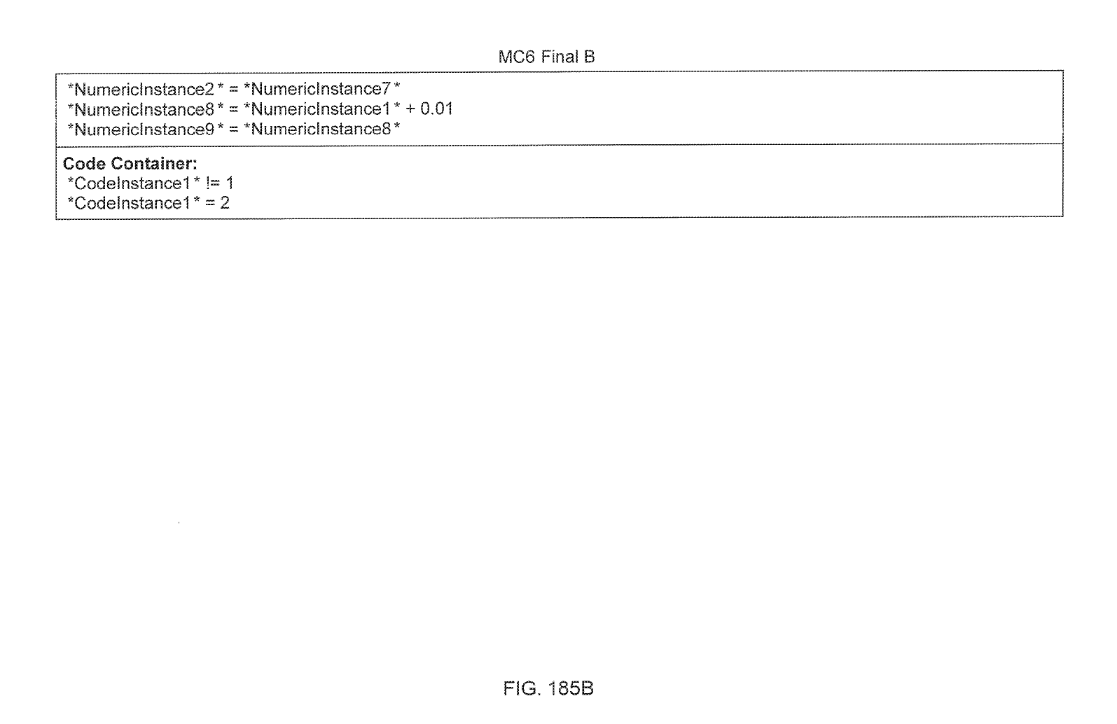

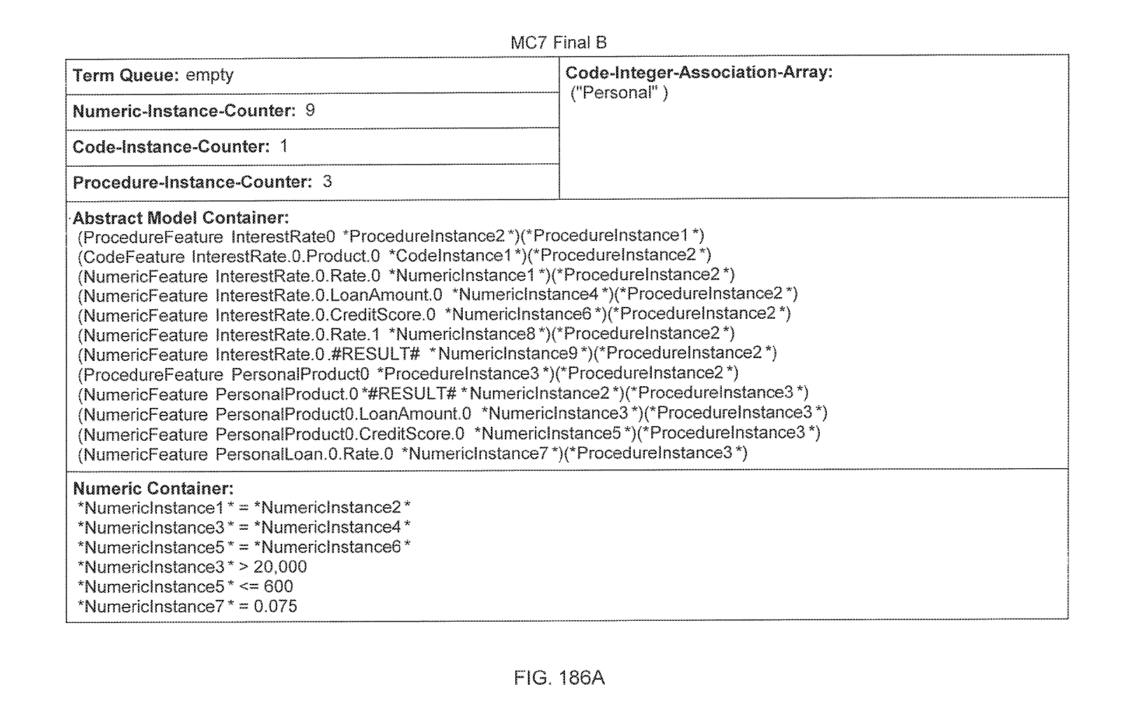

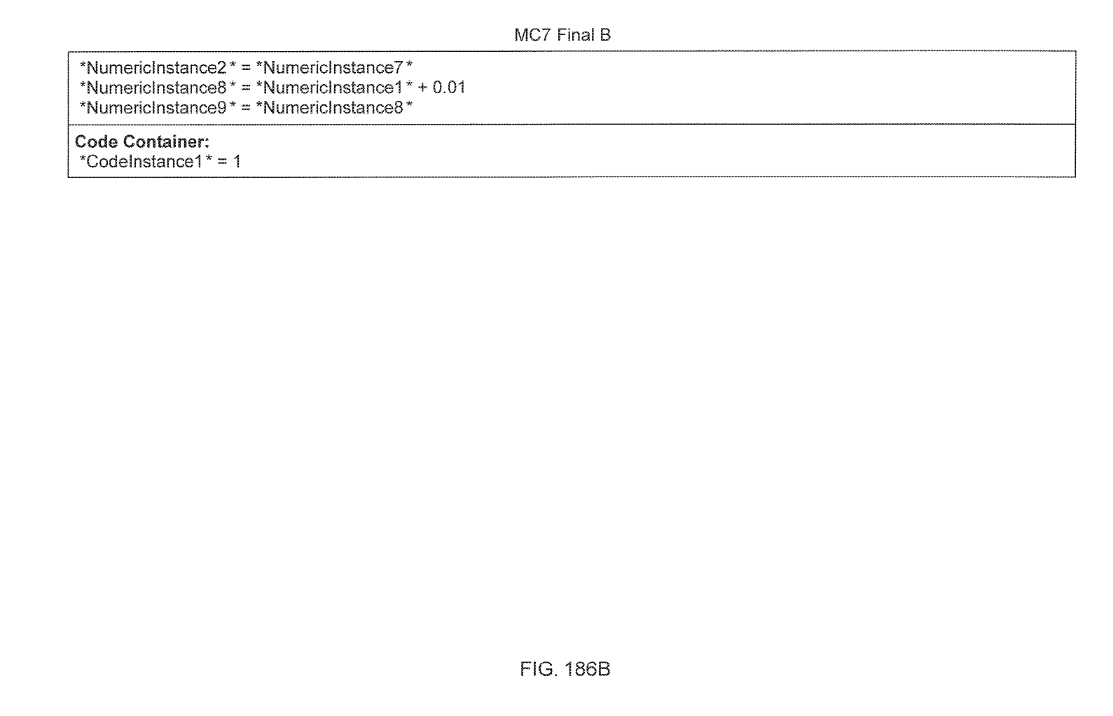

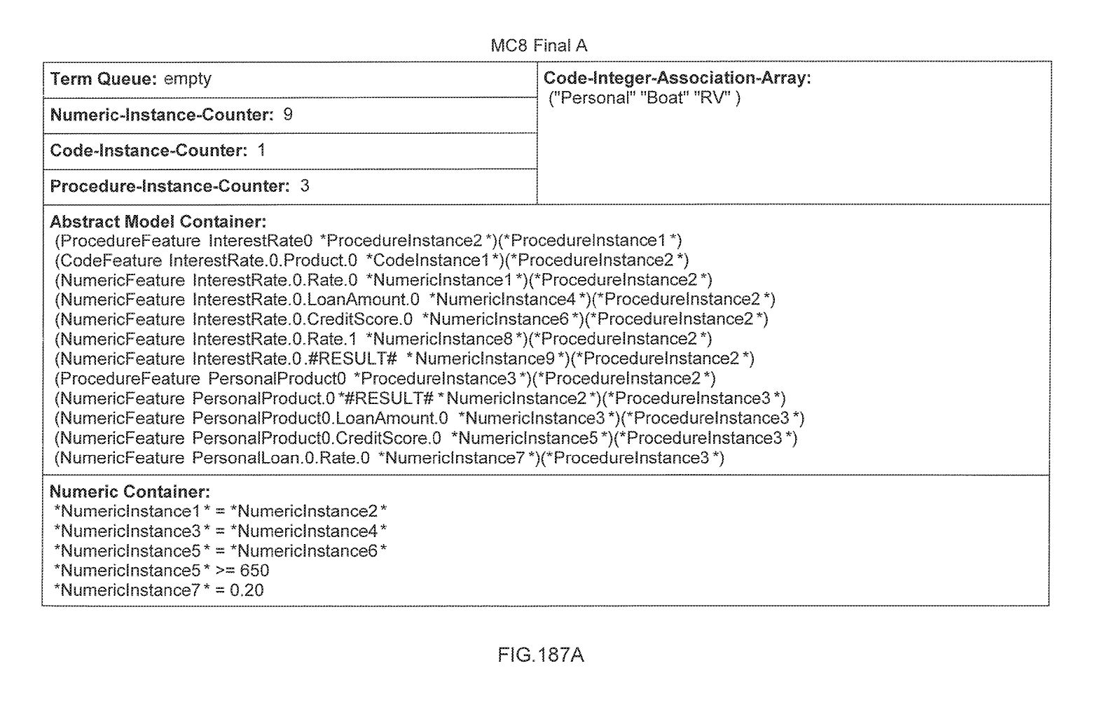

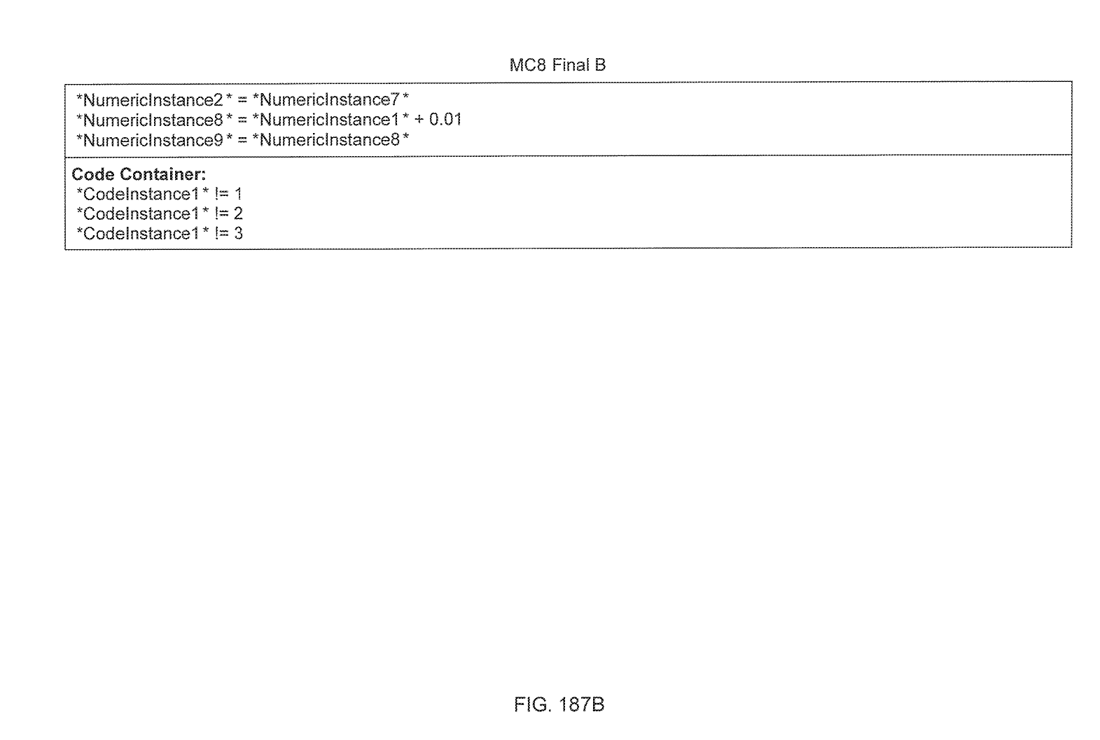

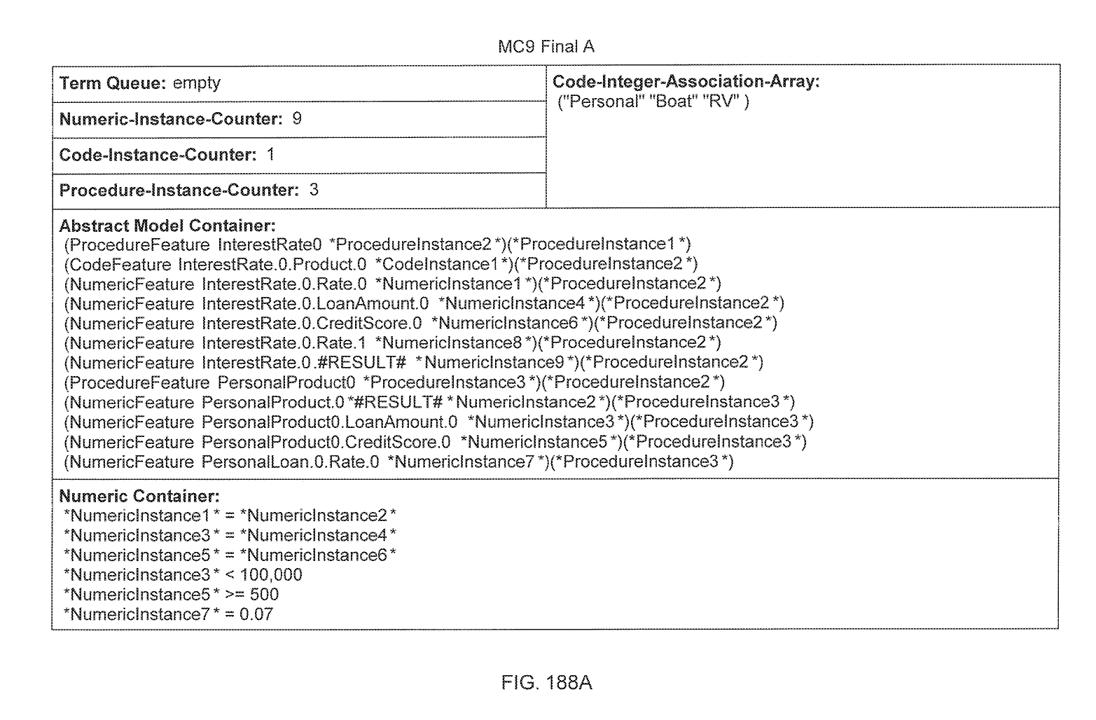

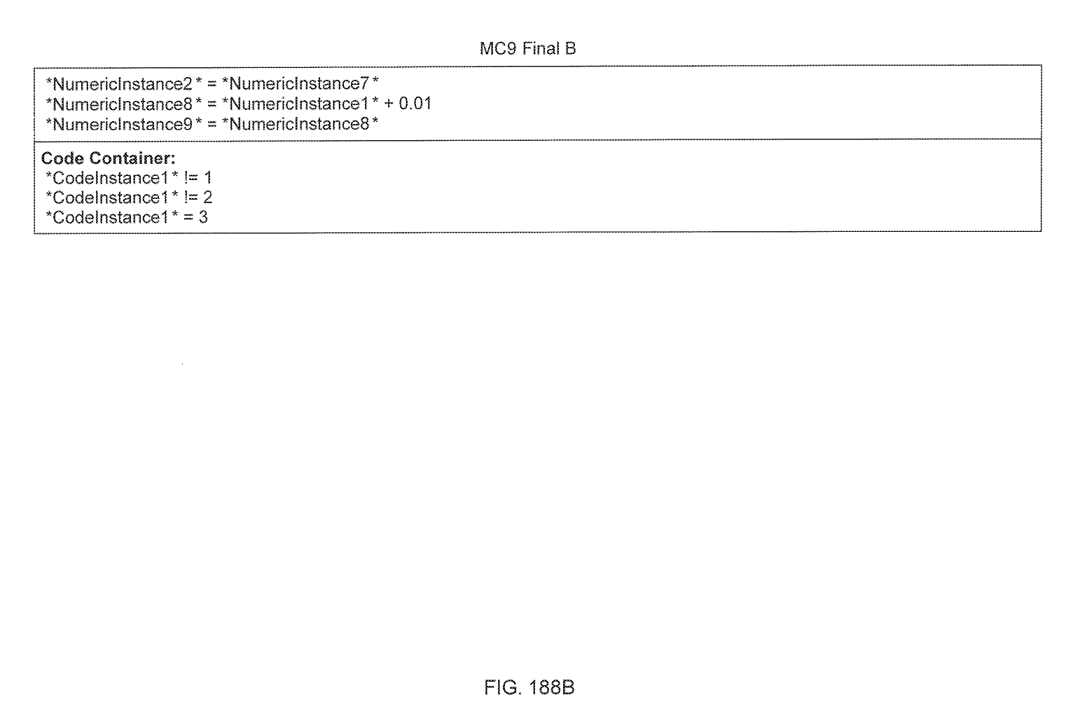

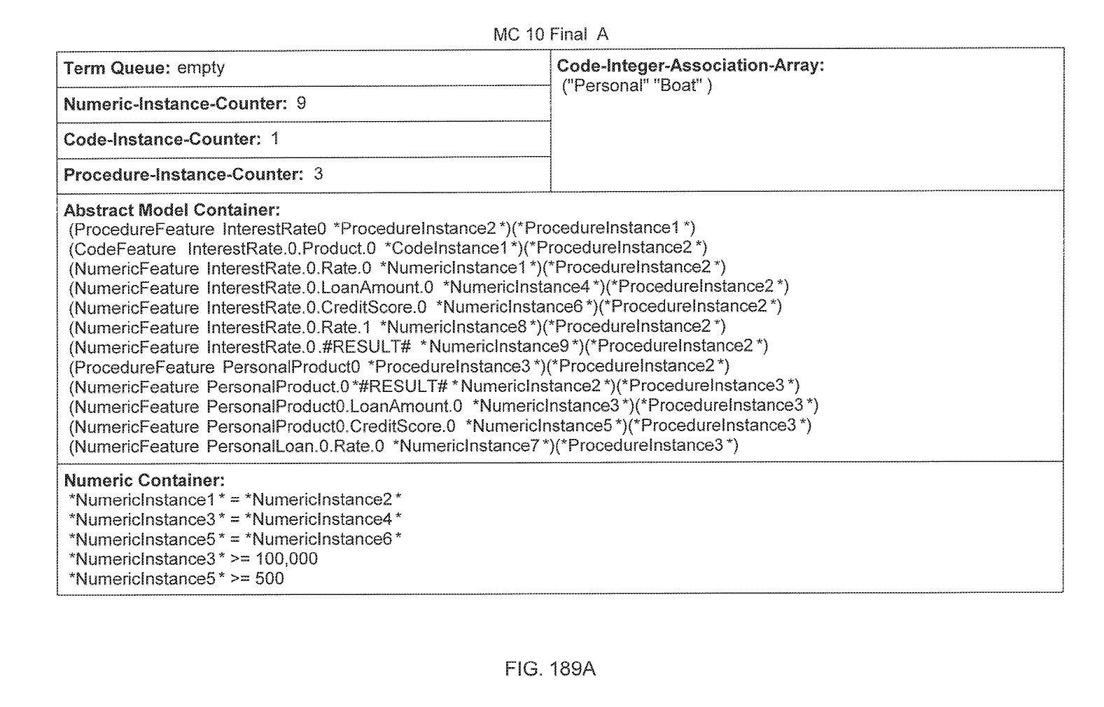

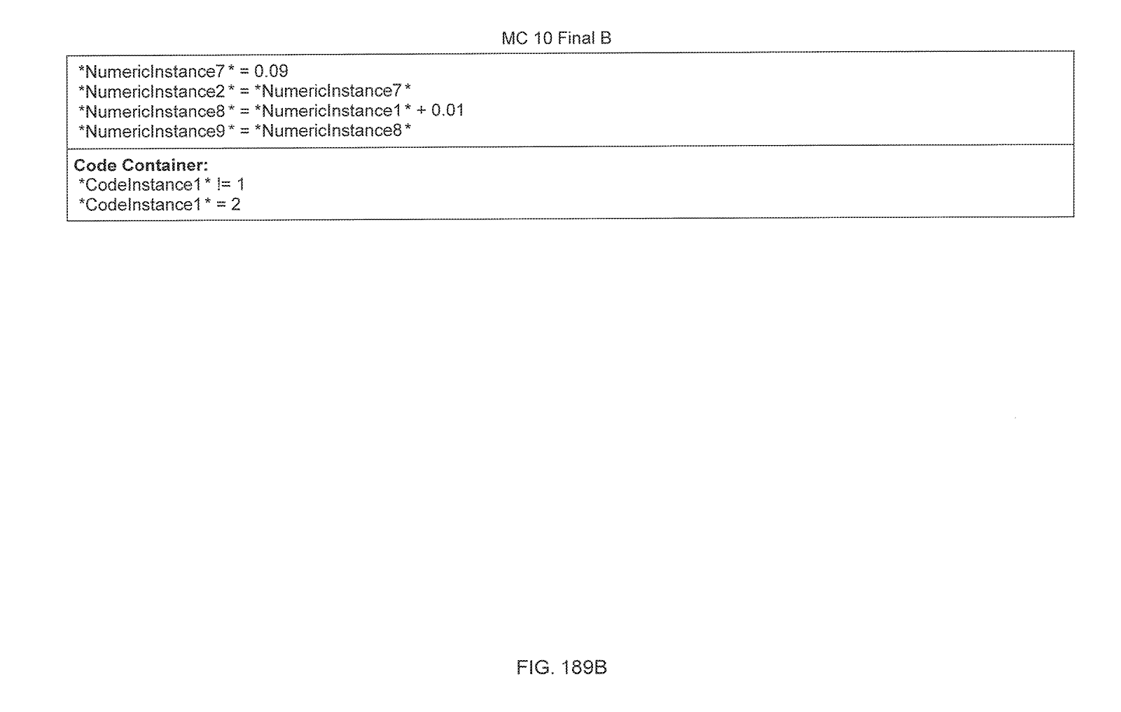

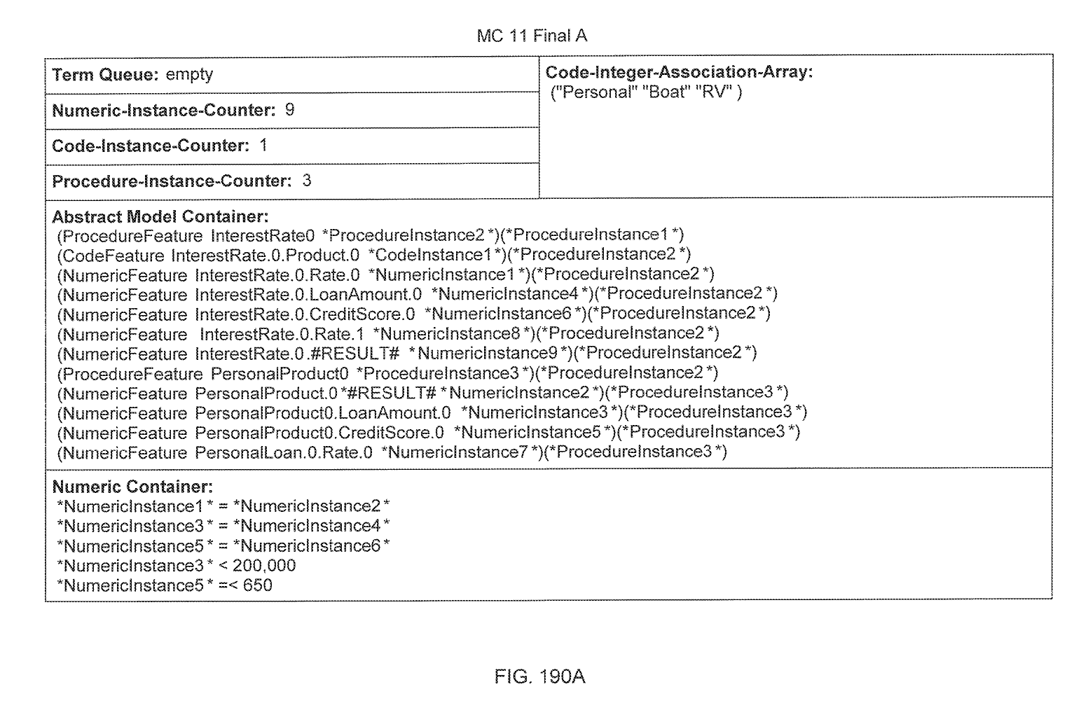

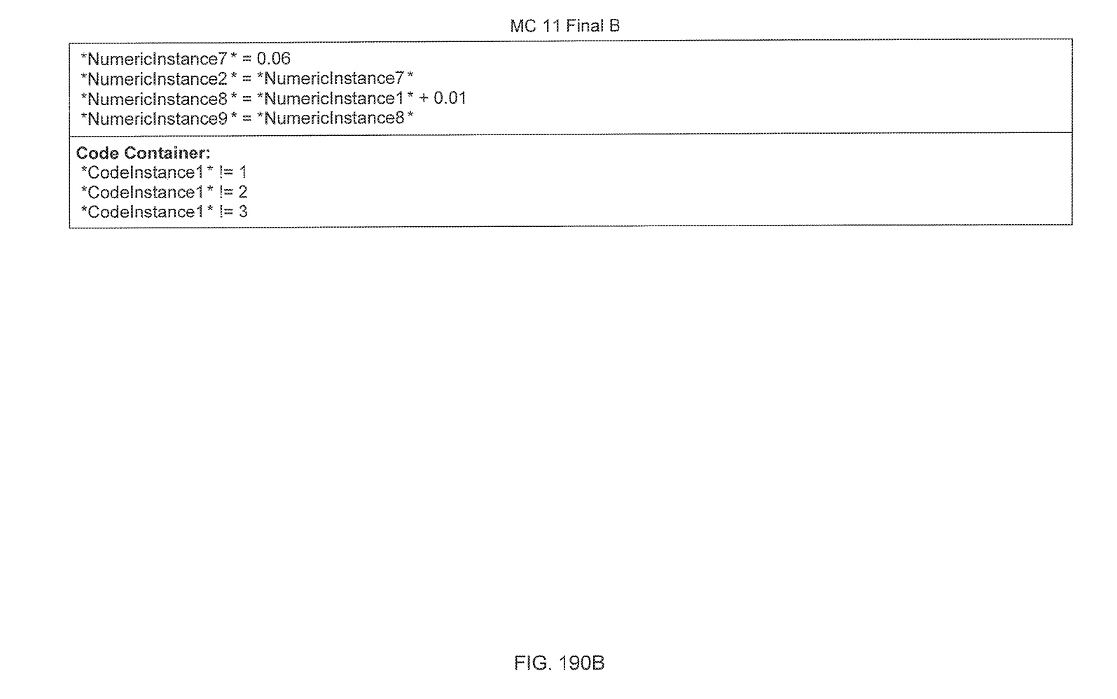

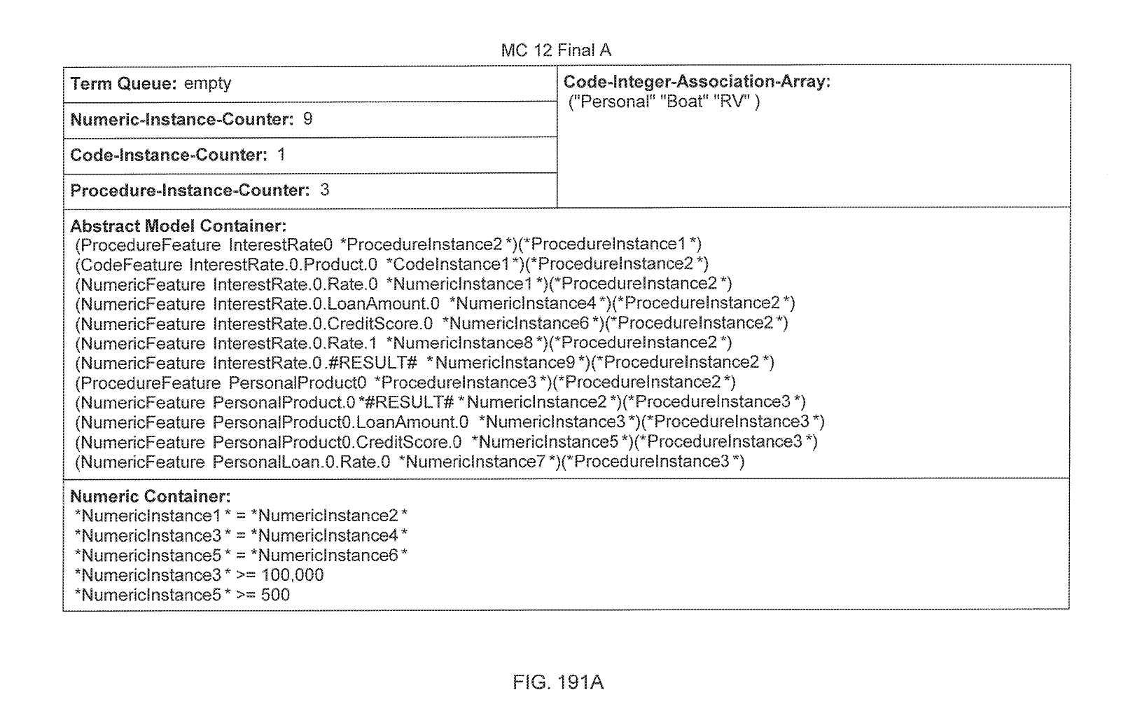

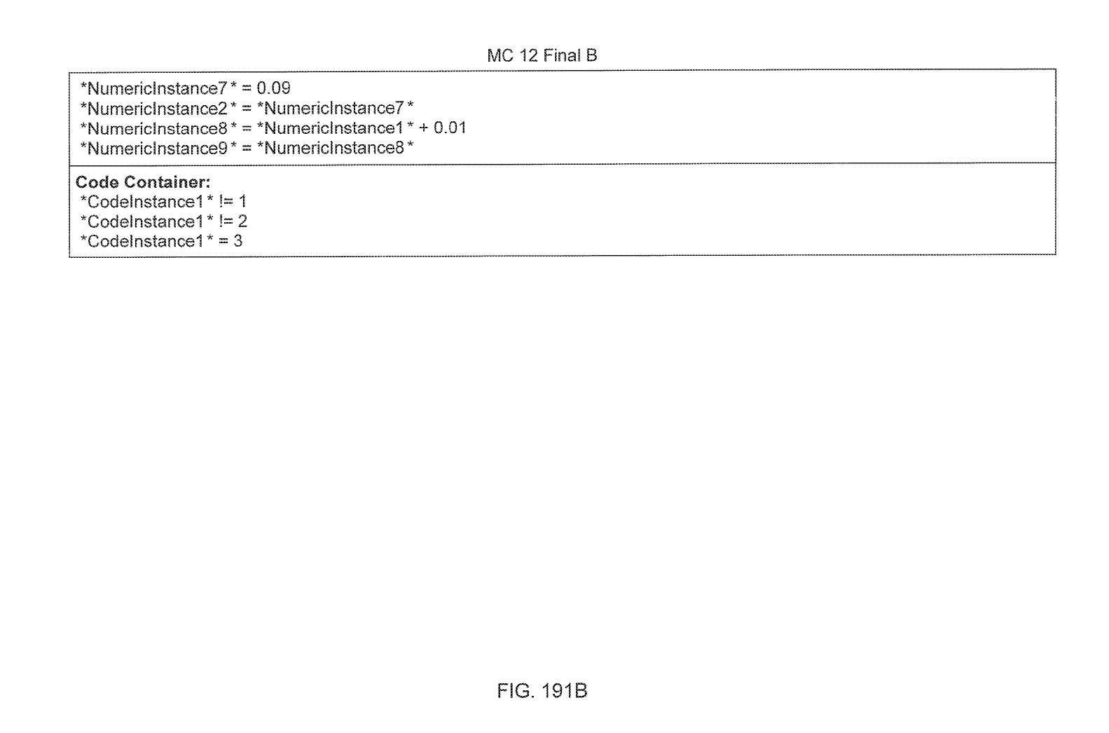

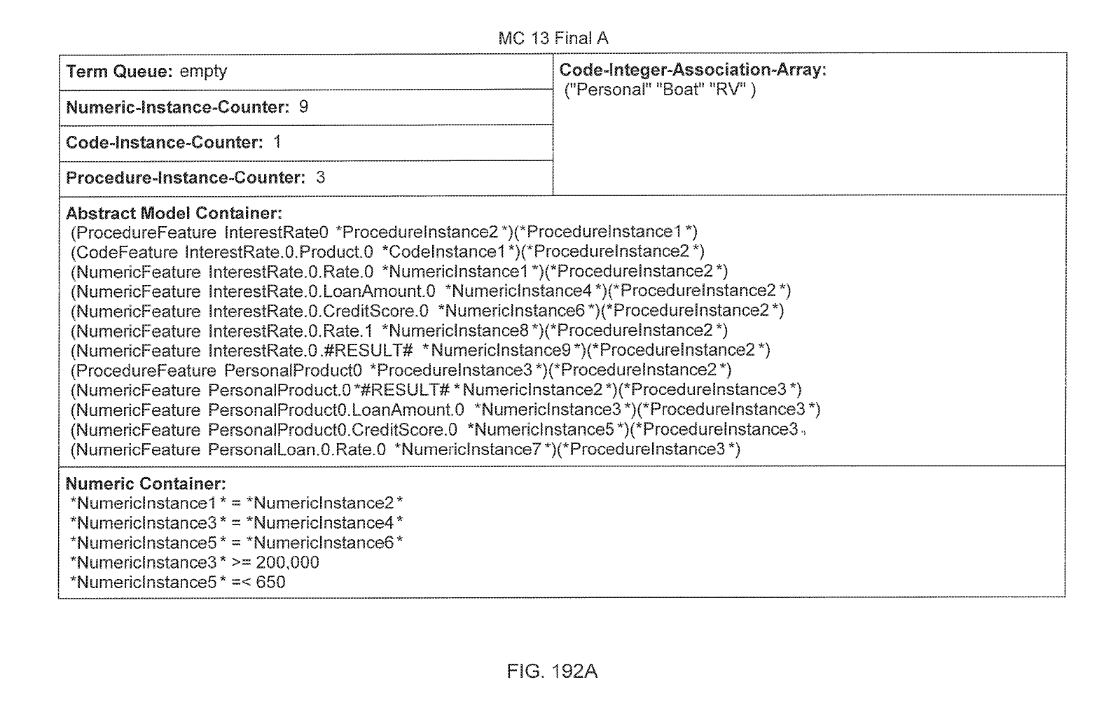

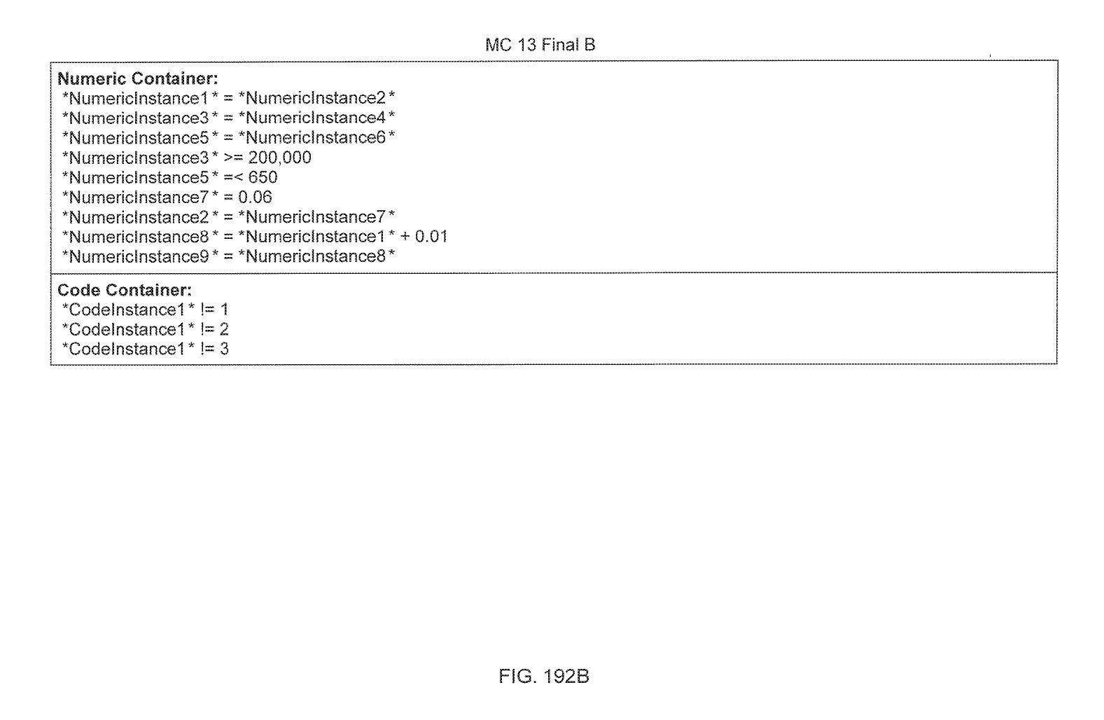

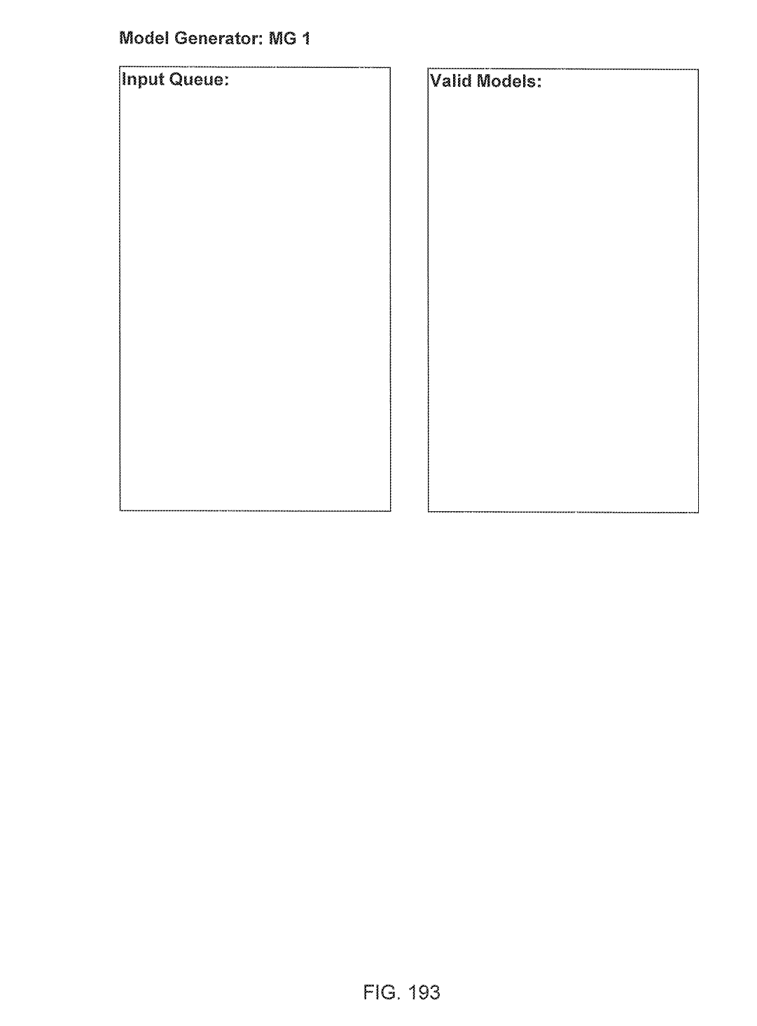

The “Model Generator MG#” diagrams (FIGS. 193-197) illustrate the state of the Model Generator as the processes modify it. The following running description provides an overview of the example and its relation to the diagrams:
Generate All Patterns. This graph receives the model logic corresponding to the “InterestRate” and generated by the translation process.
The first model container is created. The initial term is created from the input model logic expression and a new procedure instance;
The new term is added to the term queue, and control is passed to Generate Pattern Model.

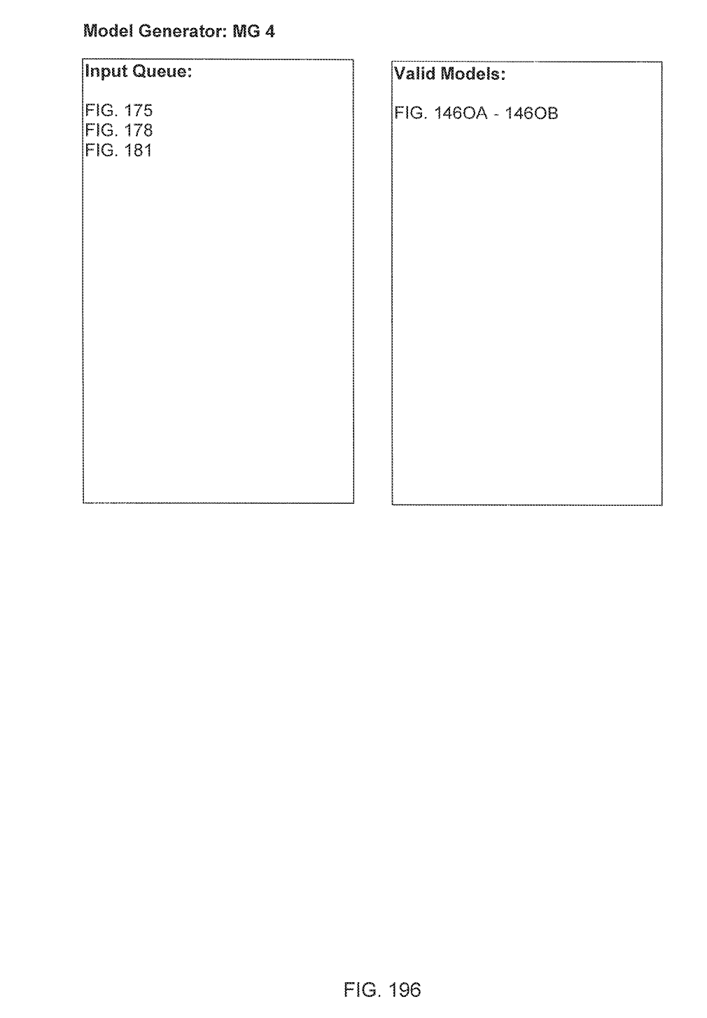

The state of the process after this stage is illustrated in diagrams Model Generator MG 1 (FIG. 196), Model Container MC1 1 (FIG. 146A-146OB), and MC1 Queue 1 (FIGS. 147A-147F).
2. Generate Pattern Model. This graph is passed a specific Model Container; it removes the first and currently only term in Term-Queue, and matches it in the “Pattern Model Generation Table” to determine the action.
The “And” row of the table is matched;
Then a new term with the same instance is created from the first sub-expression of the “And” and asserted to the first position of the Term Queue;
A new “And” is created from the remaining sub-expressions and a term is created using the same instance, and asserted to the second position of the Term Queue.

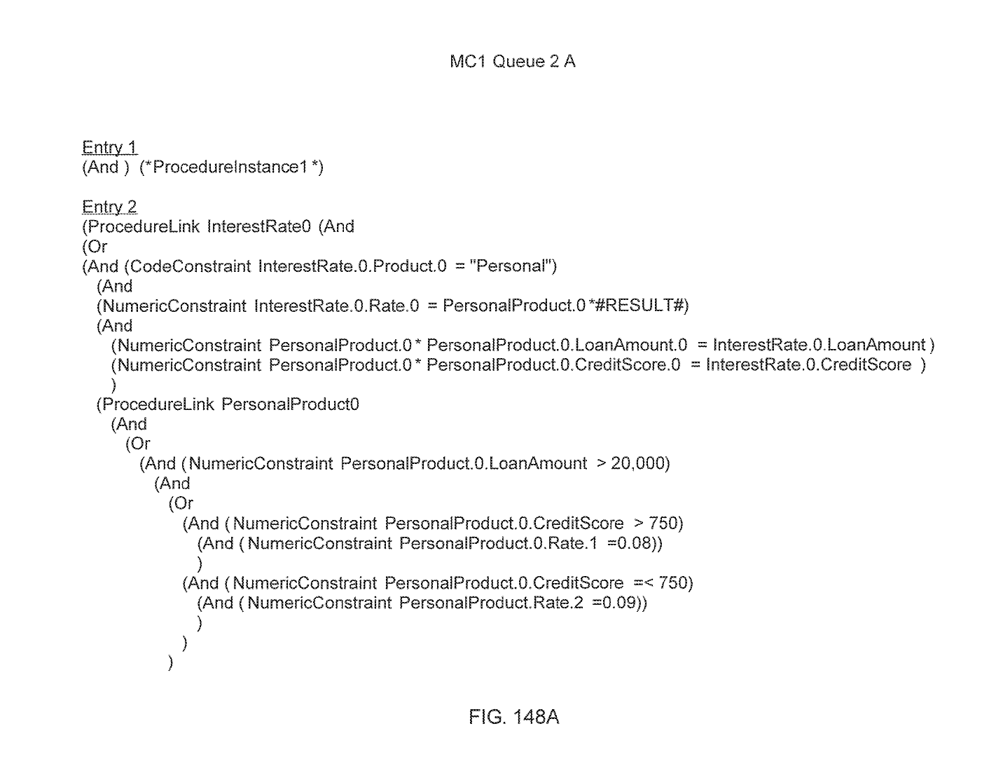

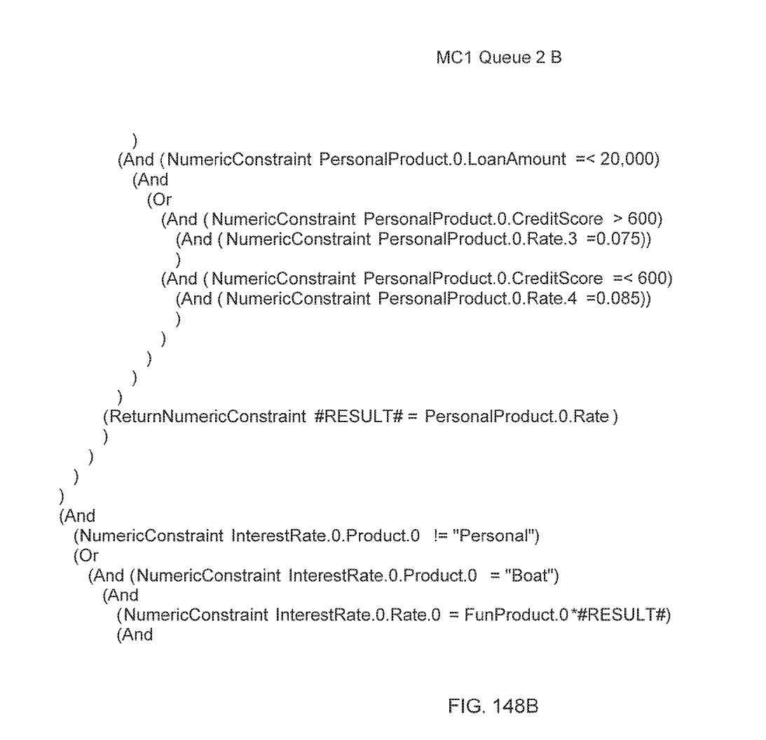

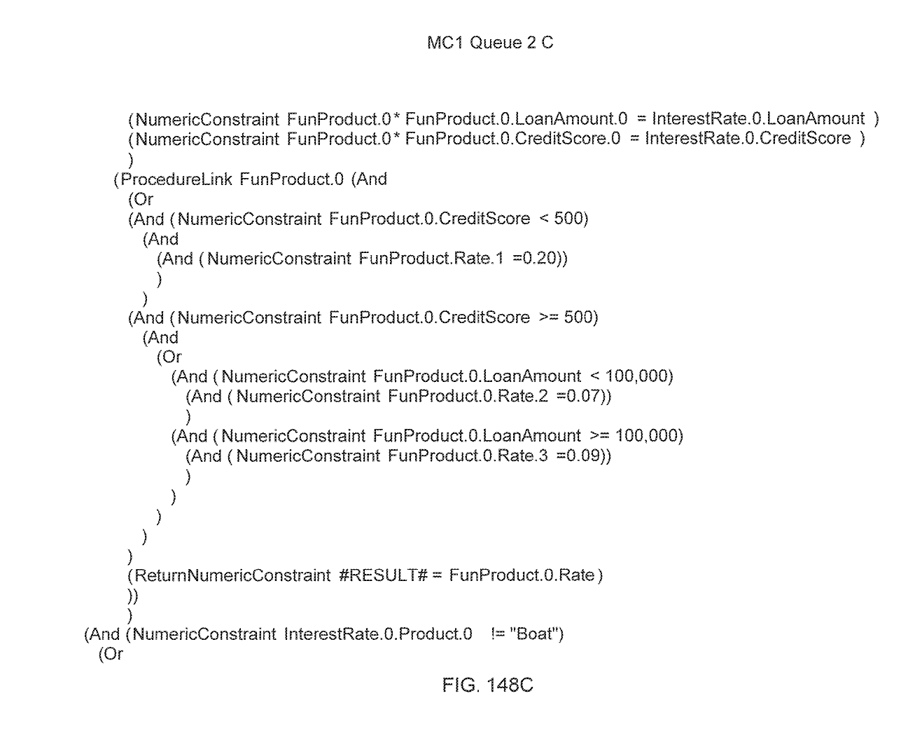

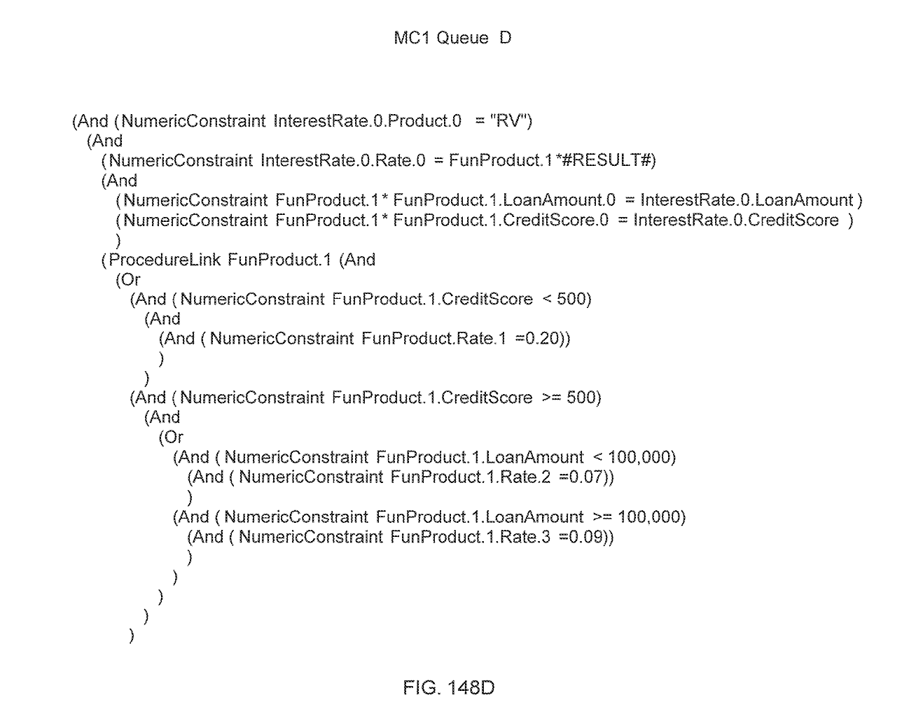

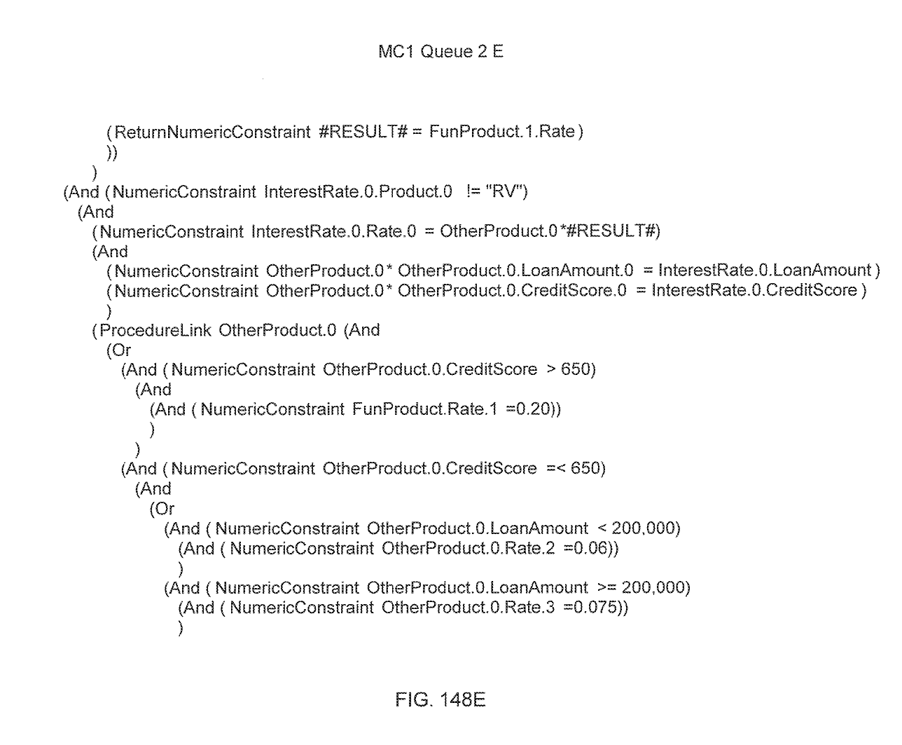

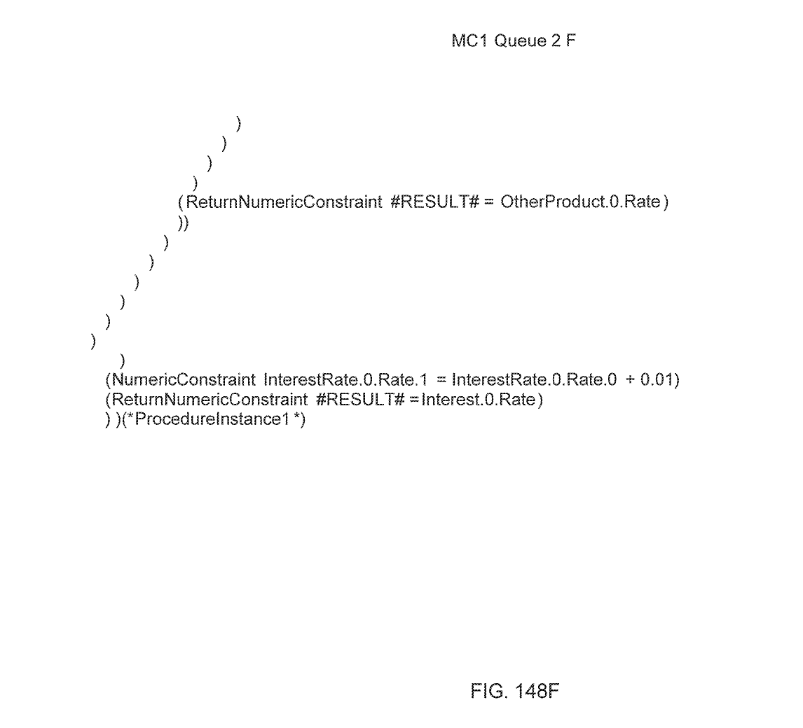

The new state of the model Container is illustrated in MC1 2 (FIG. 146B); its Term Queue is illustrated in MC1 Queue 2 (FIGS. 148A-148F).
3. Generate Pattern Model continues. It removes the first term in Term-Queue, and matches it in the “Pattern Model Generation Table” to determine the action.
The “And” row of the table is matched;
The “And” has no sub-expressions, so no action is taken

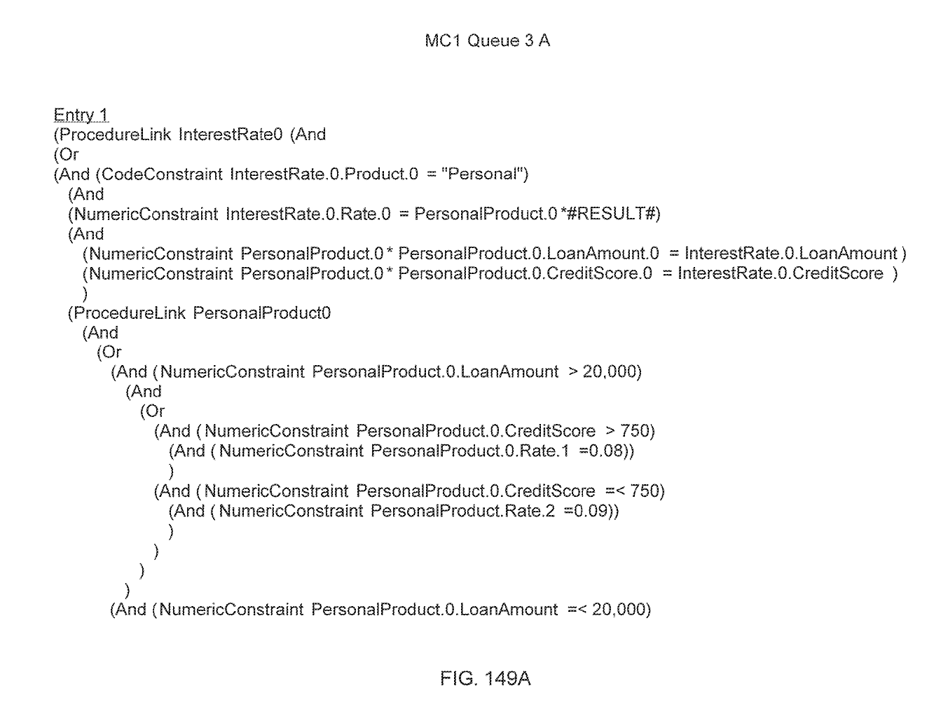

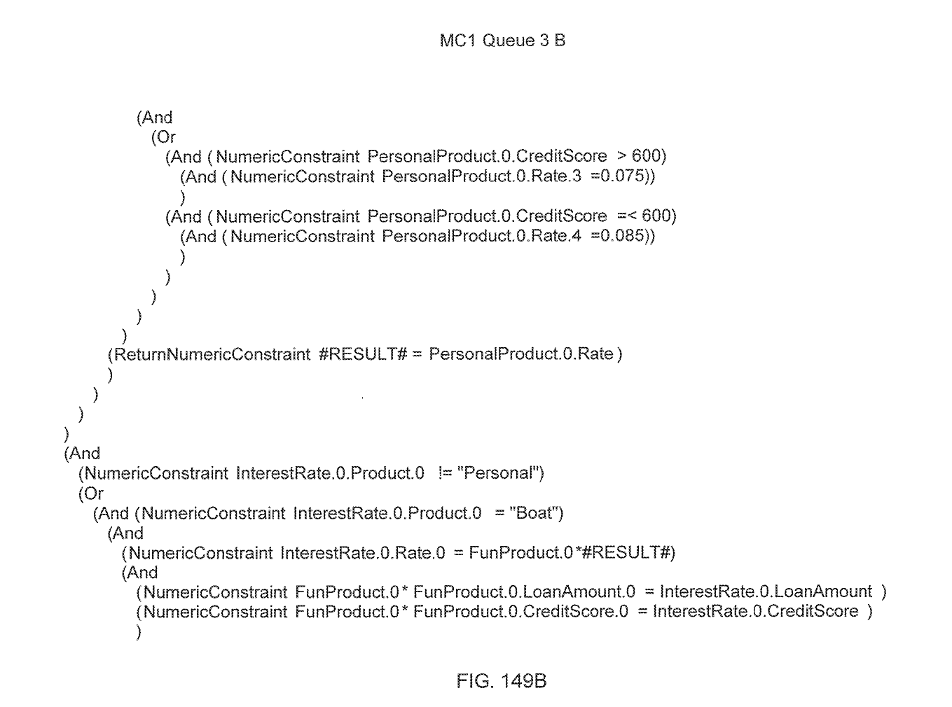

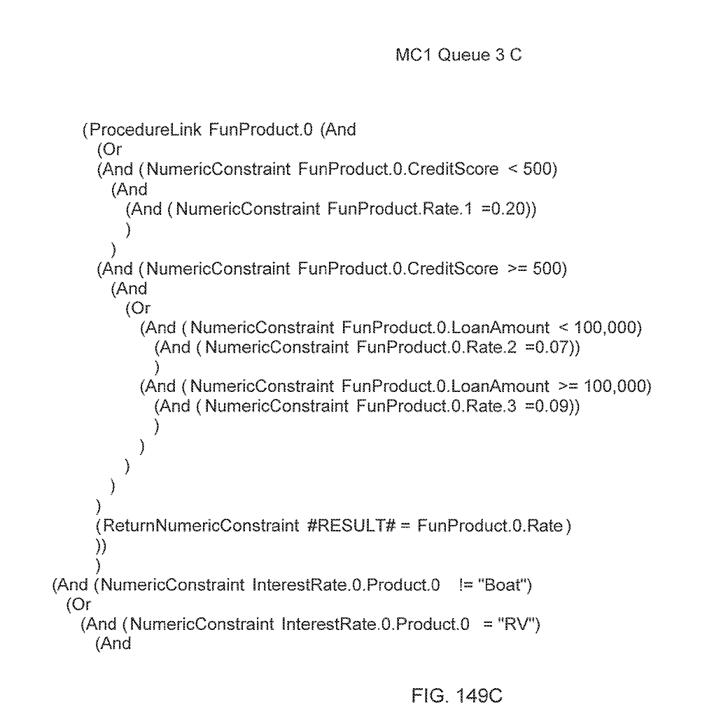

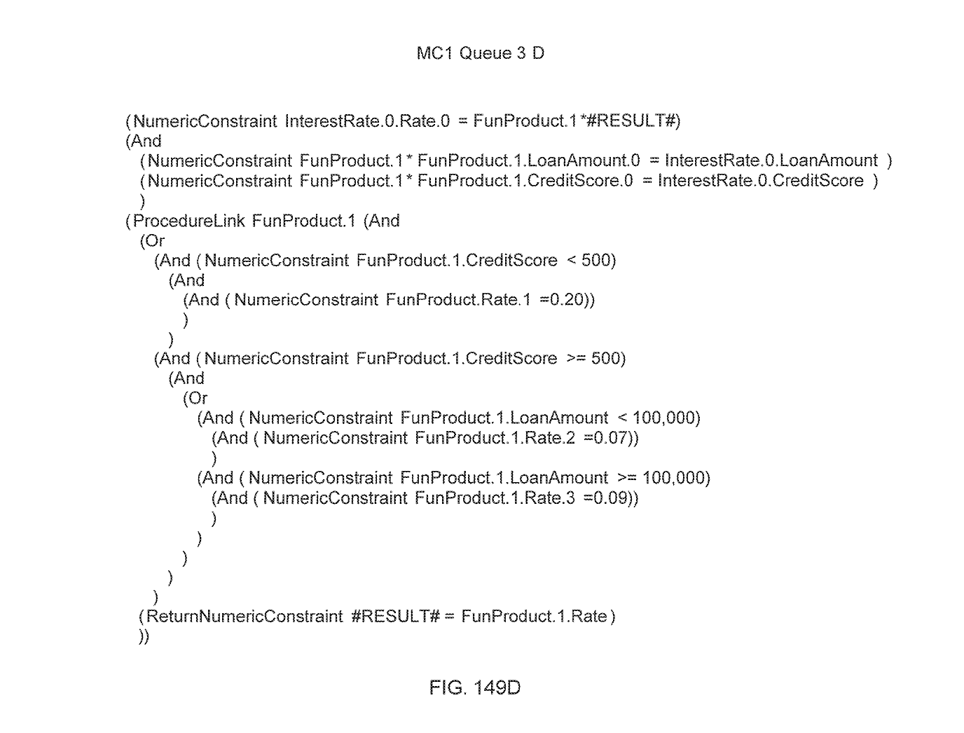

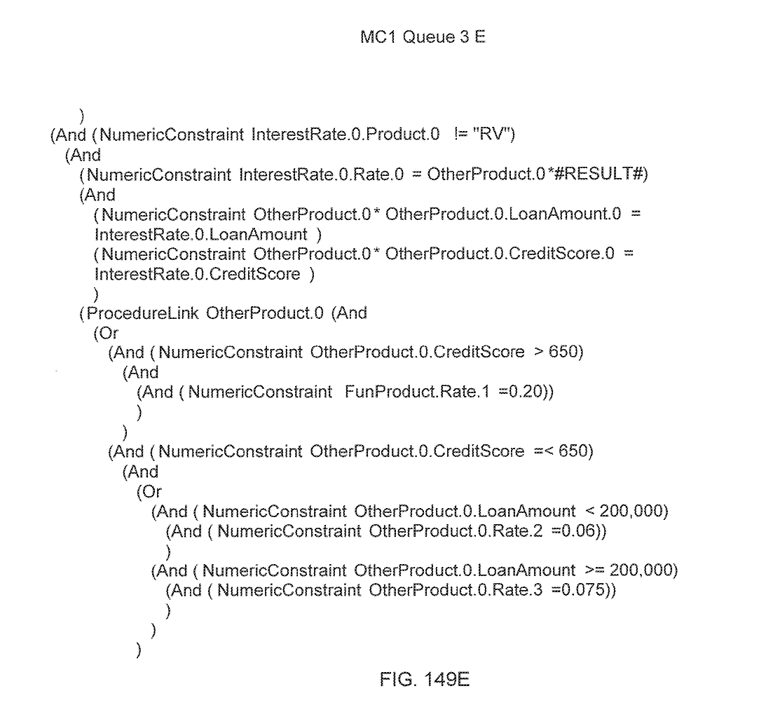

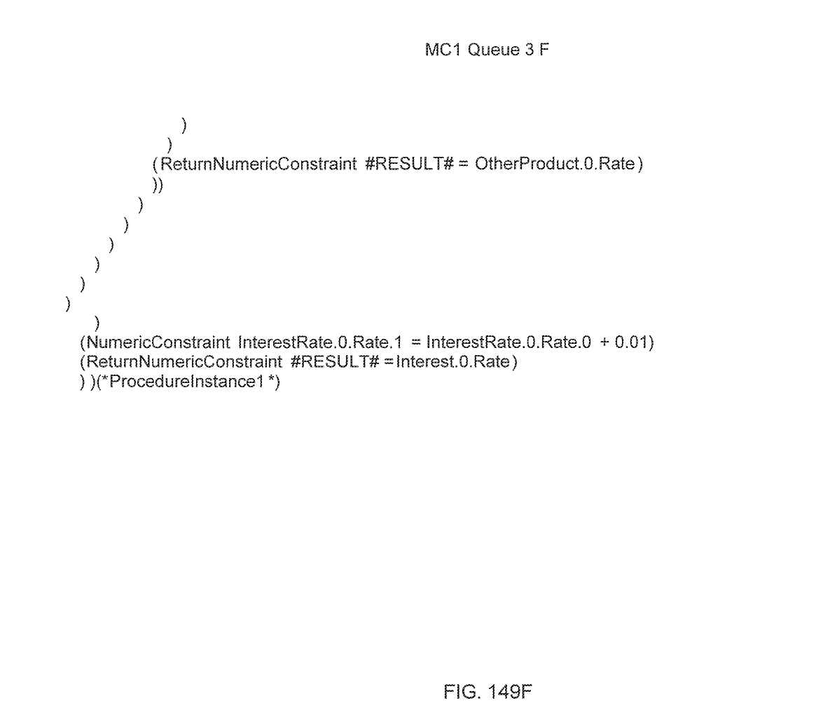

The new state of the model Container is illustrated in MC1 3 (FIG. 146C); its Term Queue is illustrated in MC1 Queue 3 (FIGS. 149A-149F).
4. Generate Pattern Model continues. It removes the first term in Term-Queue, and matches it in the “Pattern Model Generation Table” to determine the action.
The “ProcedureLink” row of the table is matched;
A new procedure instance is allocated
A ProcedureFeature term is asserted to represent the link from the entry procedure to the sub-procedure
A Procedure Call marker is asserted, to mark the invocation point in the Term Queue
A term is created and asserted to the Term Queue using the procedure expression portion of the Procedure Link, and the new instance.

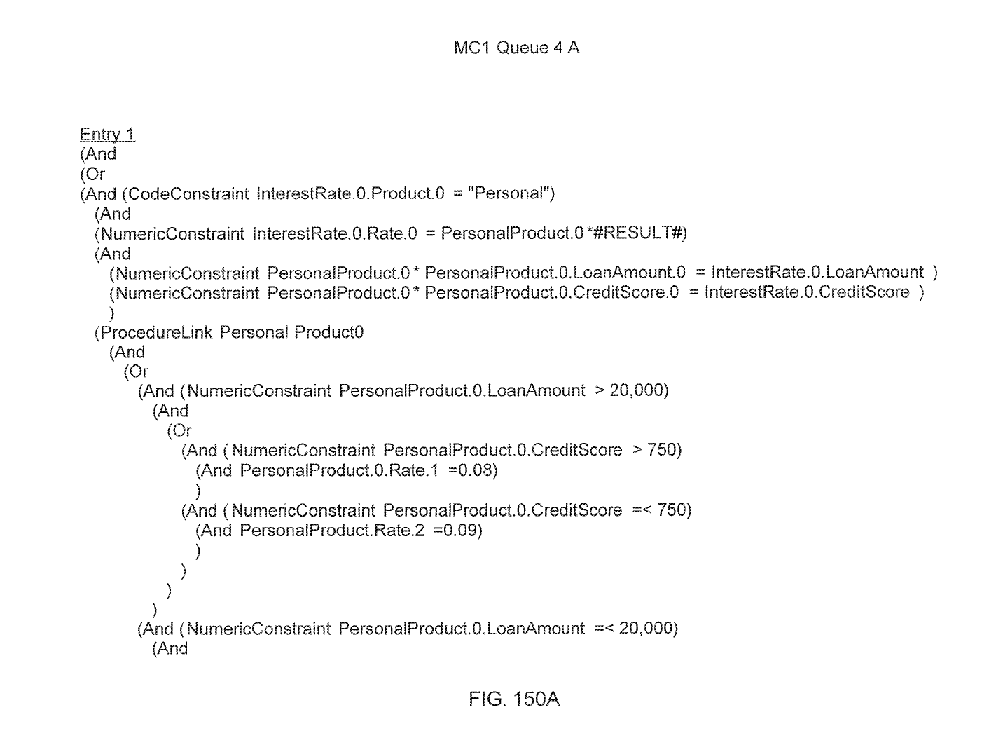

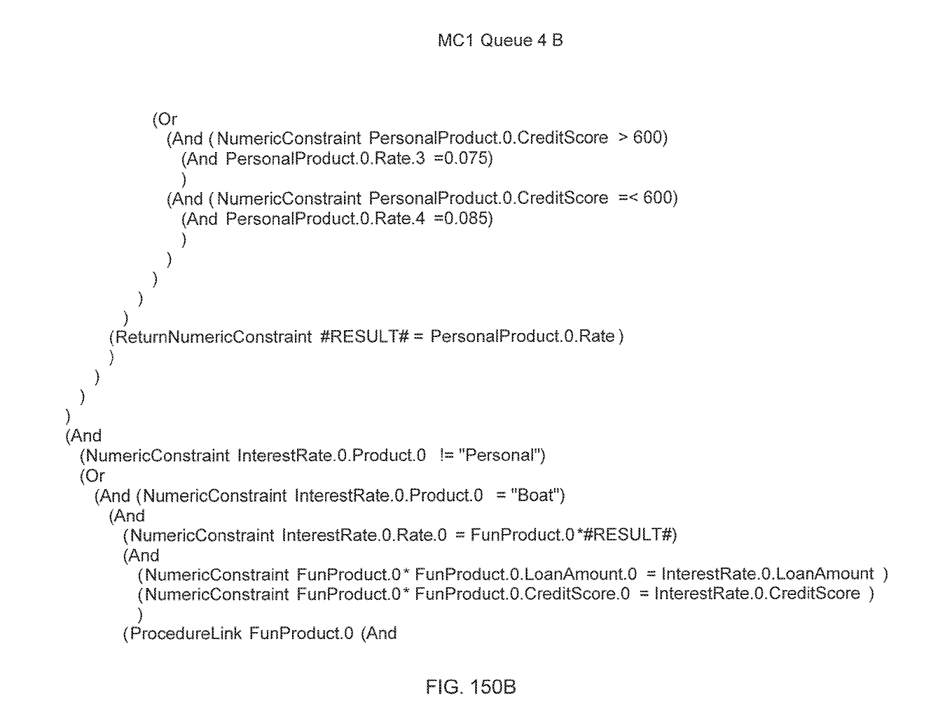

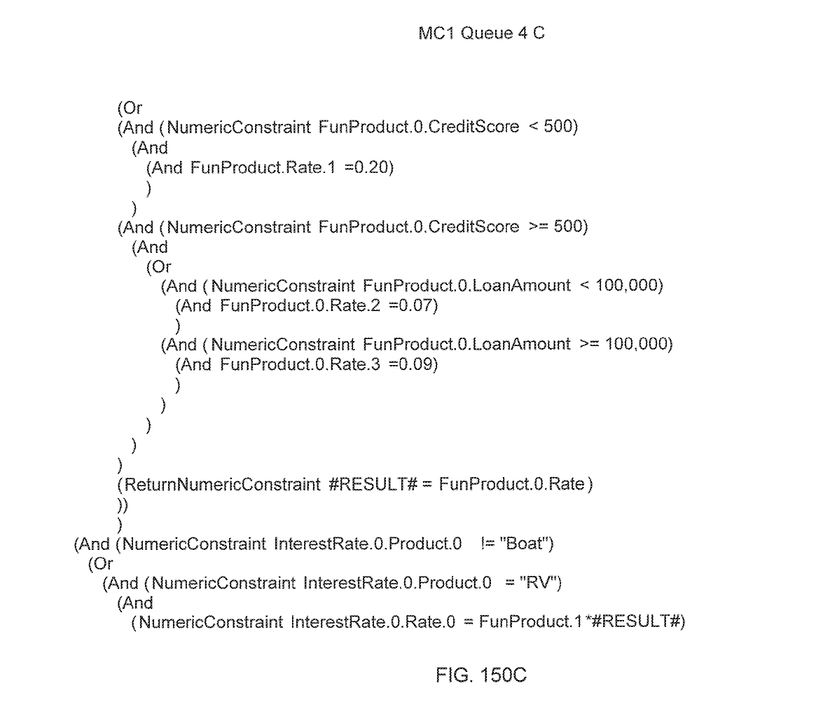

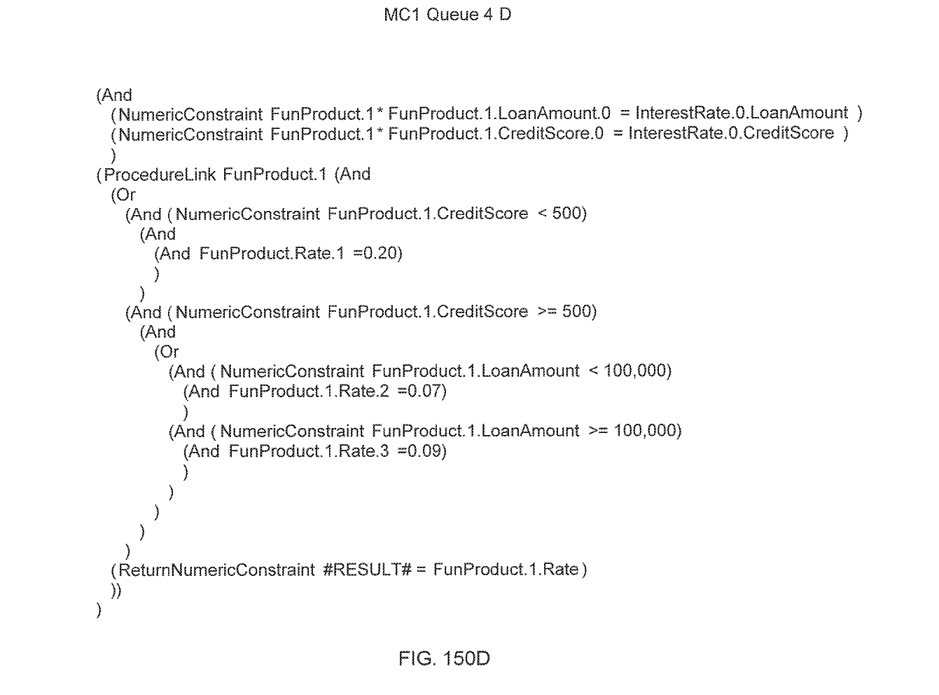

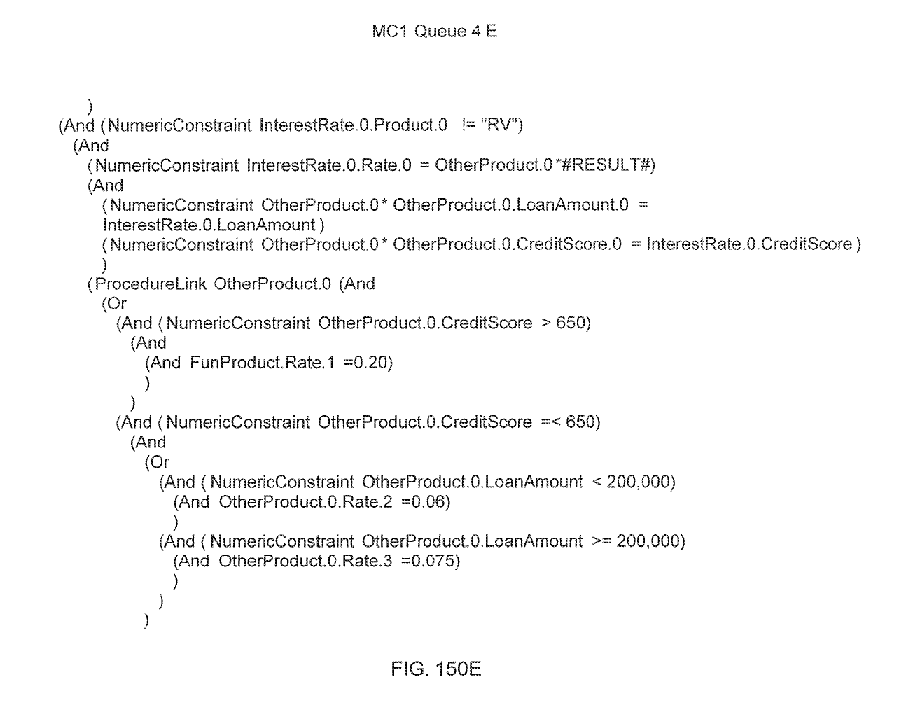

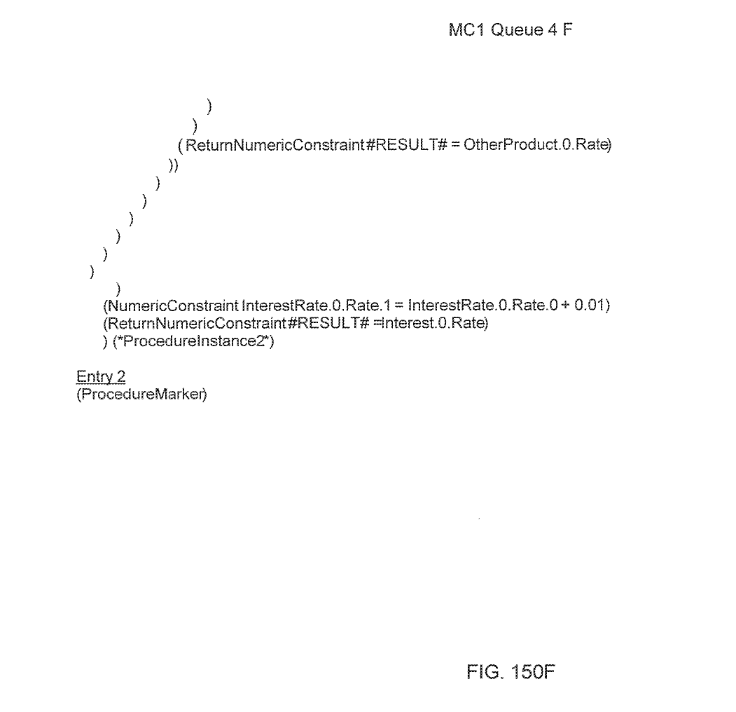

The new state of the model Container is illustrated in MC1 4 (FIG. 146D); its Term Queue is illustrated in MC1 Queue 4 (FIGS. 150A-150F).
5. Generate Pattern Model continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

The new state of the Term Queue is illustrated in MC1 Queue 5 (FIG. 146E).
6. Generate Pattern Model continues. It removes the first term in Term-Queue, and matches it in the “Pattern Model Generation Table” to determine the action.
The “Or” row of the table is matched;
A new Model Container named “MC2” is created by cloning the MC1.
The first sub-expression is added to the front of the Term Queue of the original Model Container MC1
The second sub-expression is added to the front of the Term Queue of MC2
MC2 is added to the Input Queue of the Model Generator MG1.

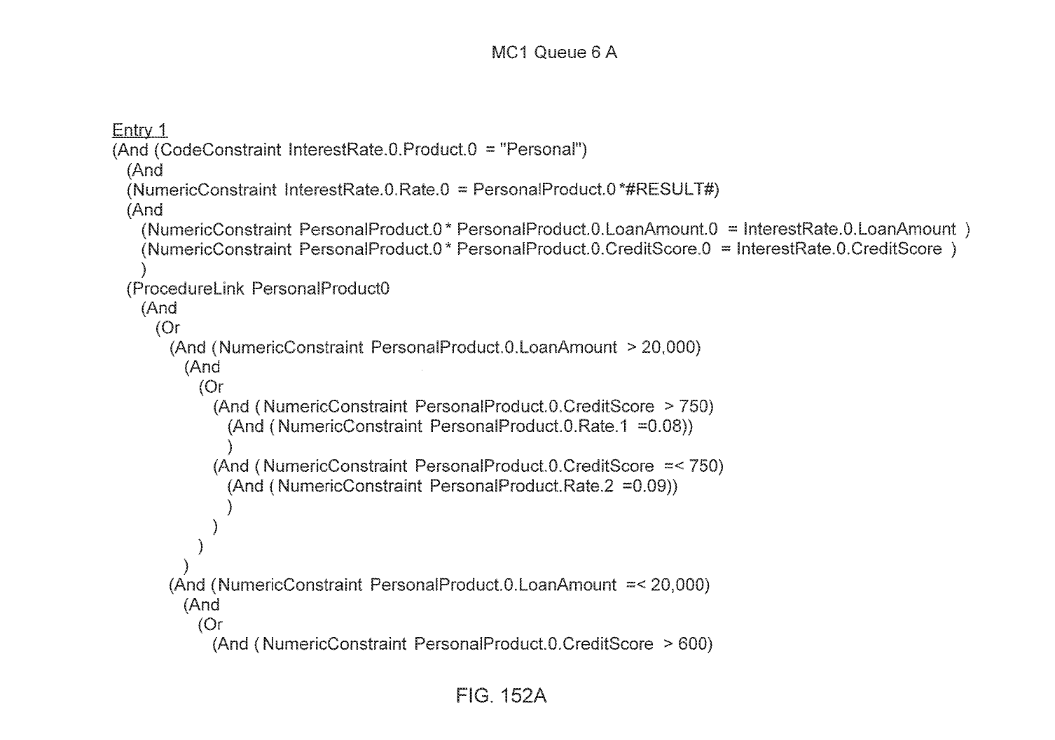

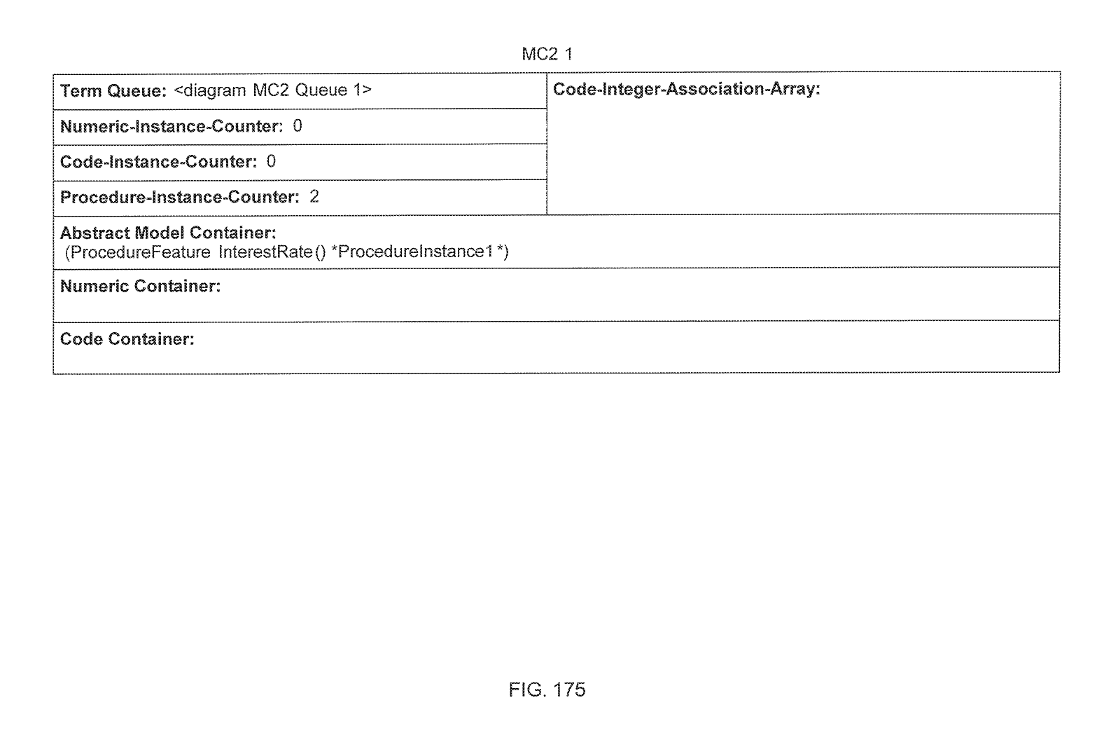

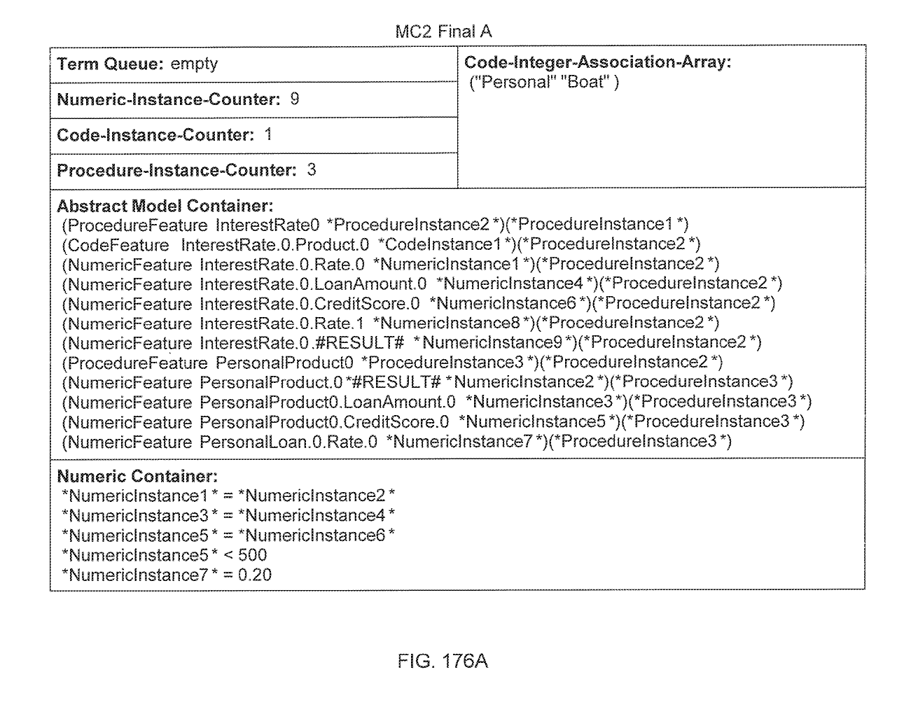

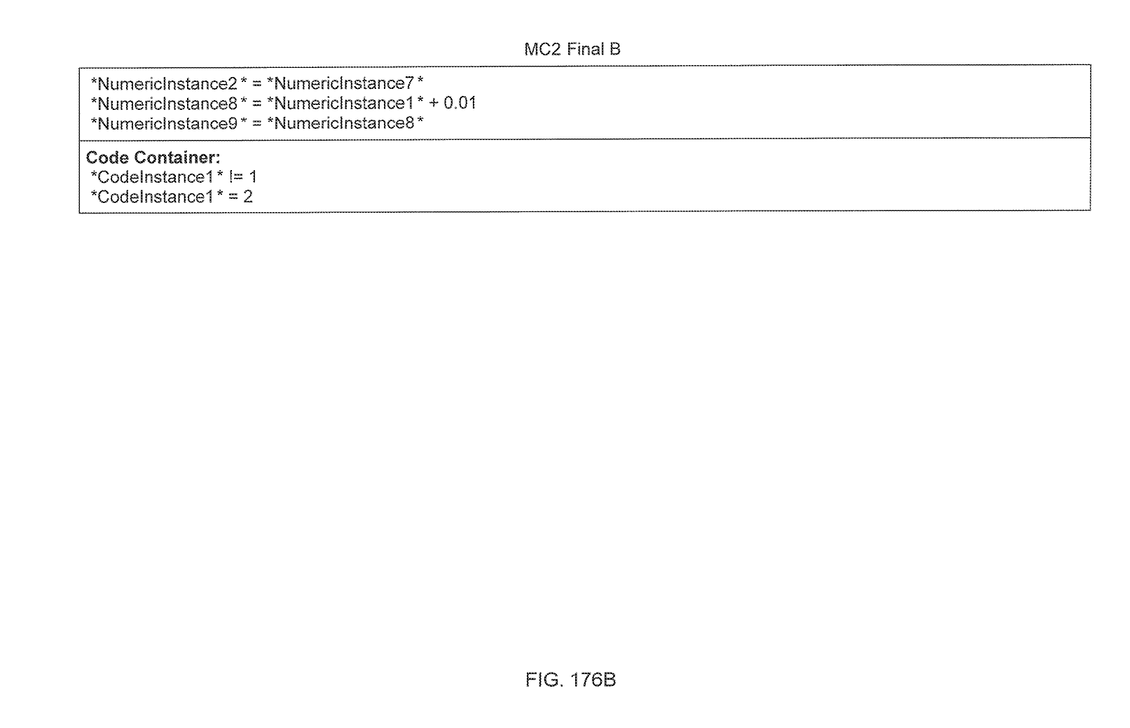

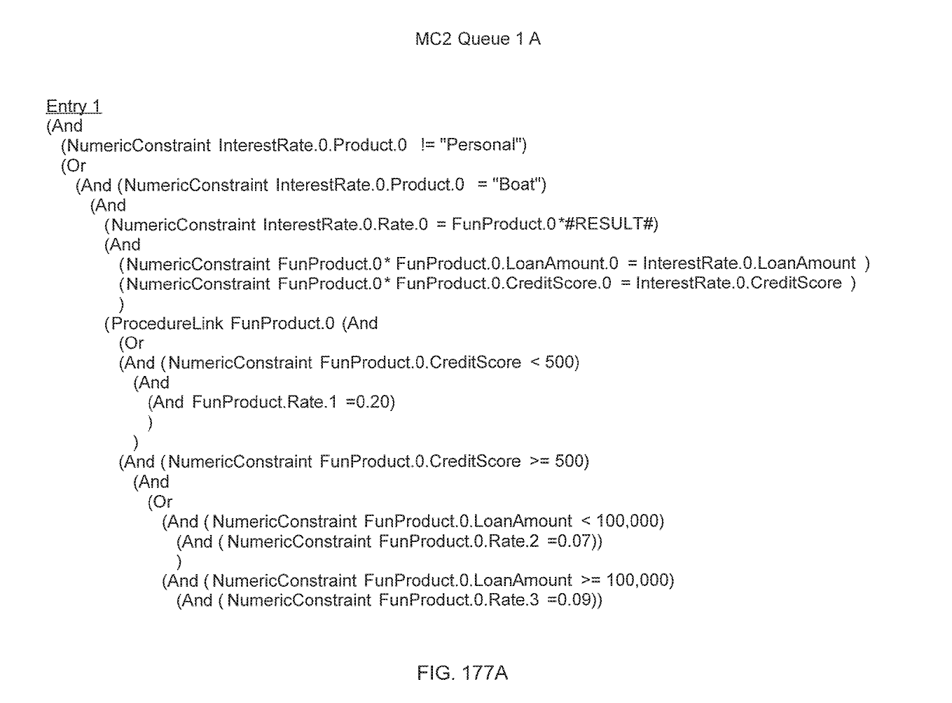

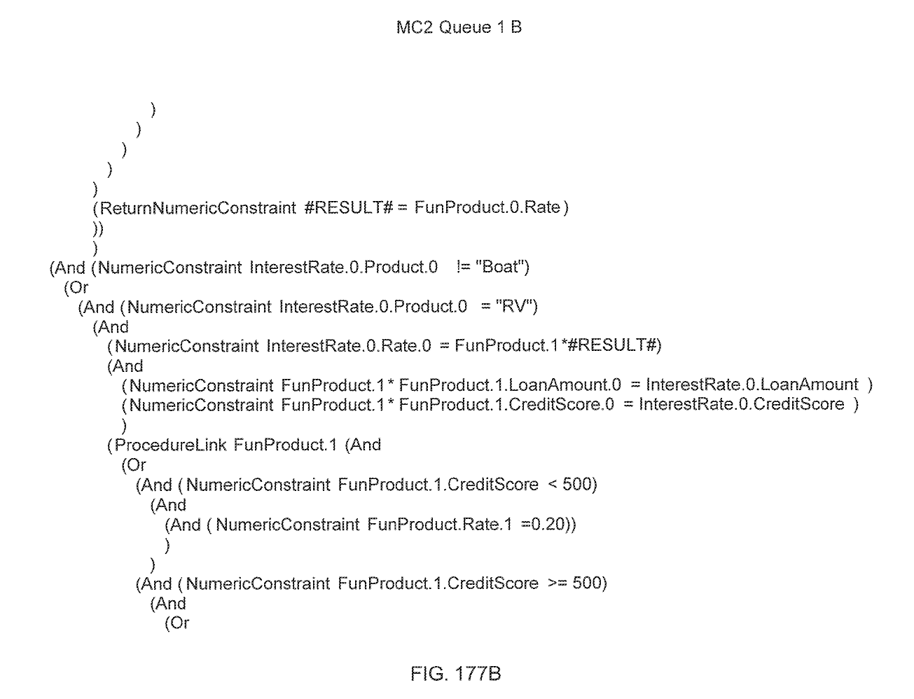

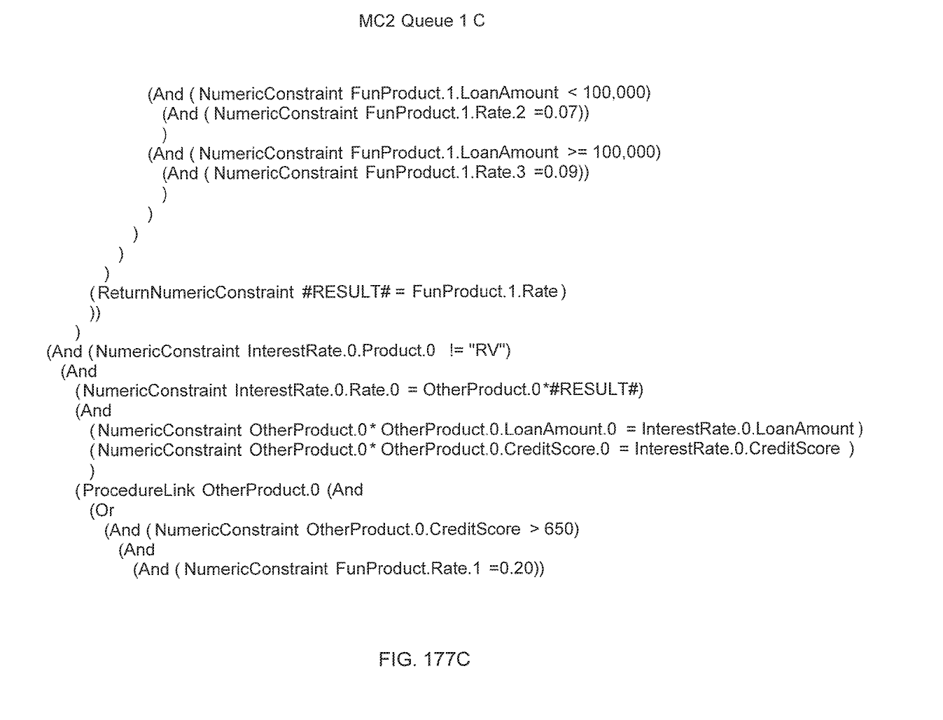

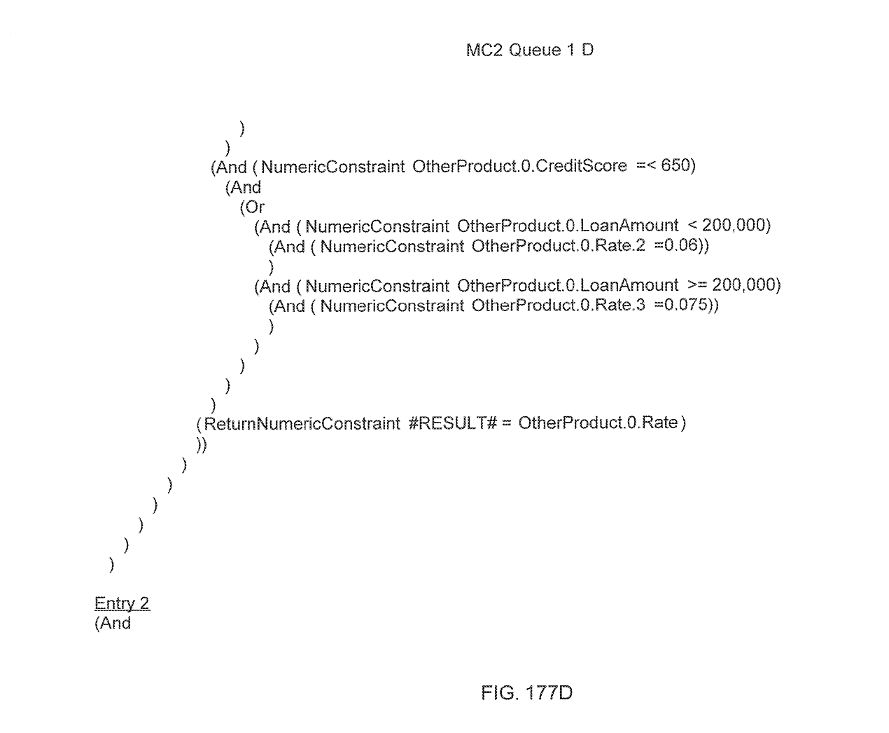

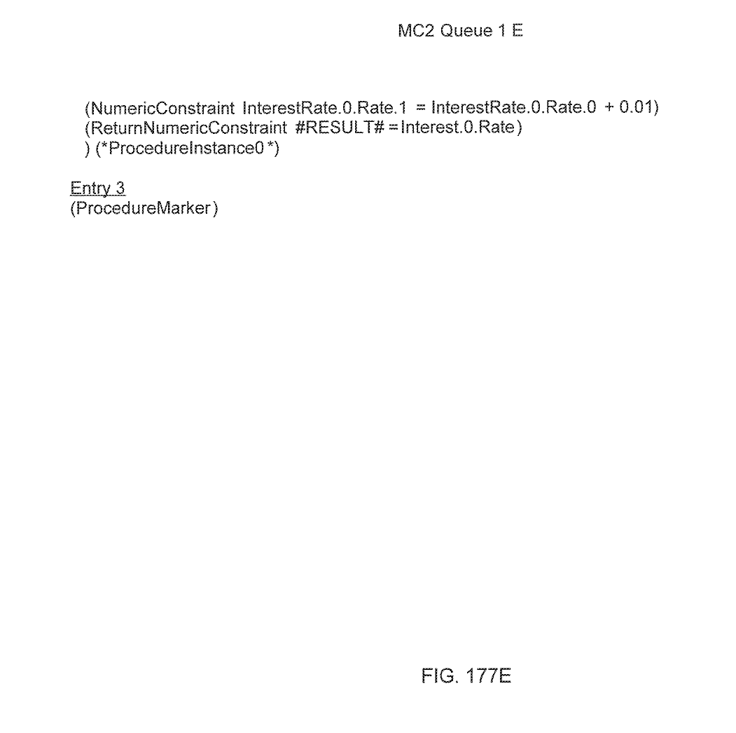

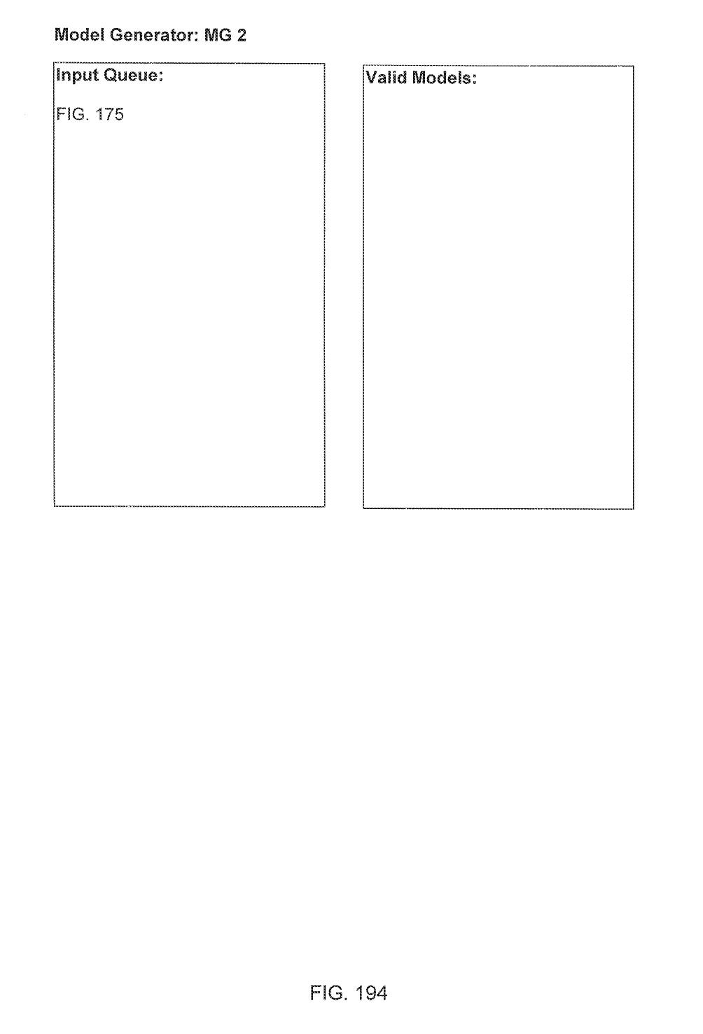

The new state of the Term Queue is illustrated in MC1 Queue 6 (FIGS. 152A-152B). The new Model Container MC2 is illustrated in diagram MC2 1 (FIG. 175). The state of MC2's queue is illustrated in diagram MC2 Queue 1 (FIGS. 177A-177B). The new state of the Model Generator is illustrated in diagram MG2 (FIG. 194).
7. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

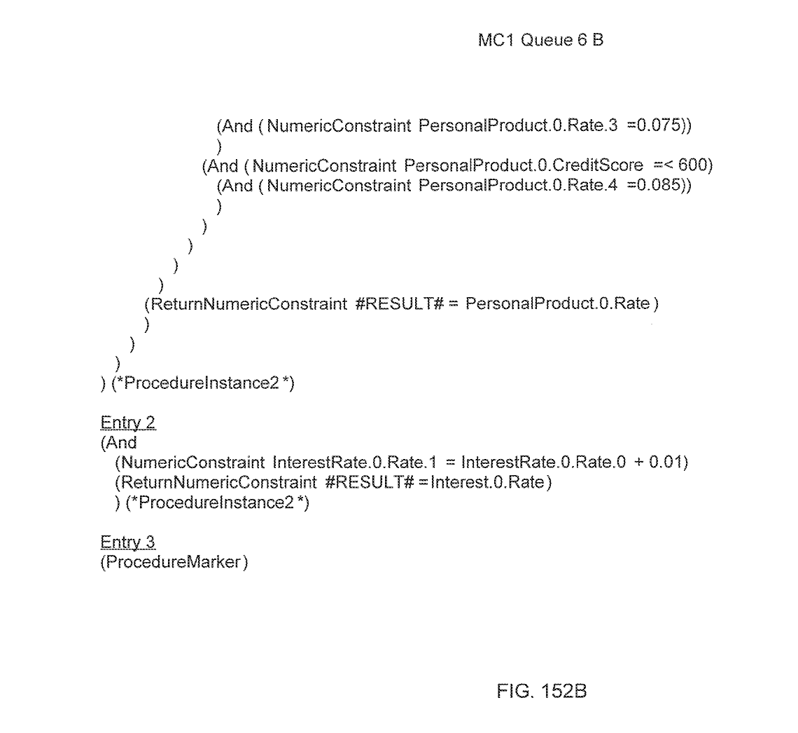

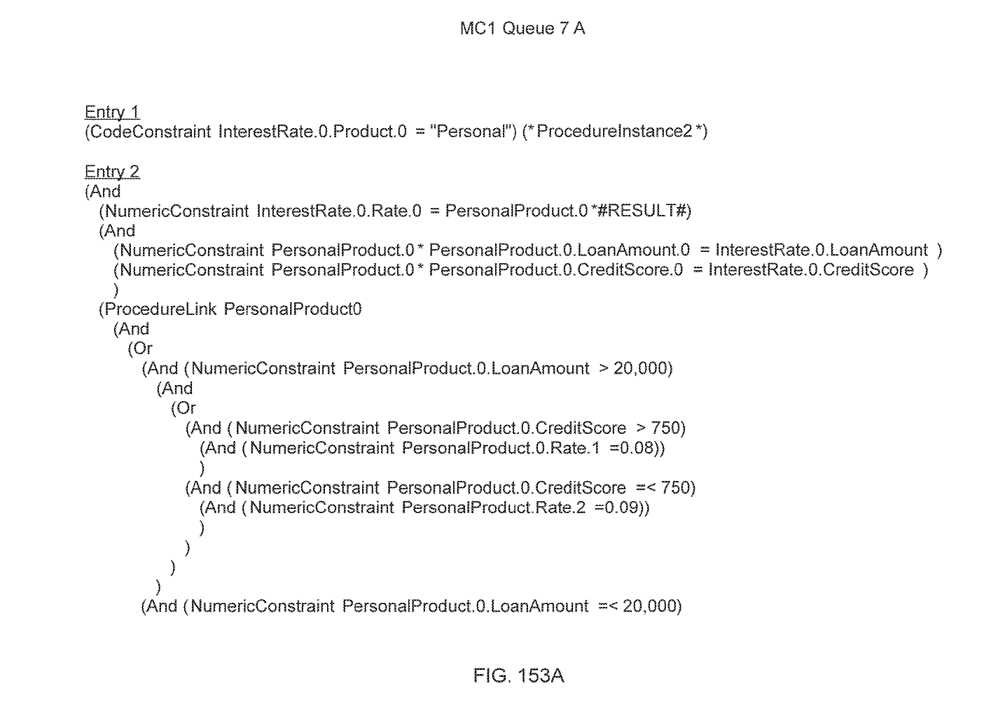

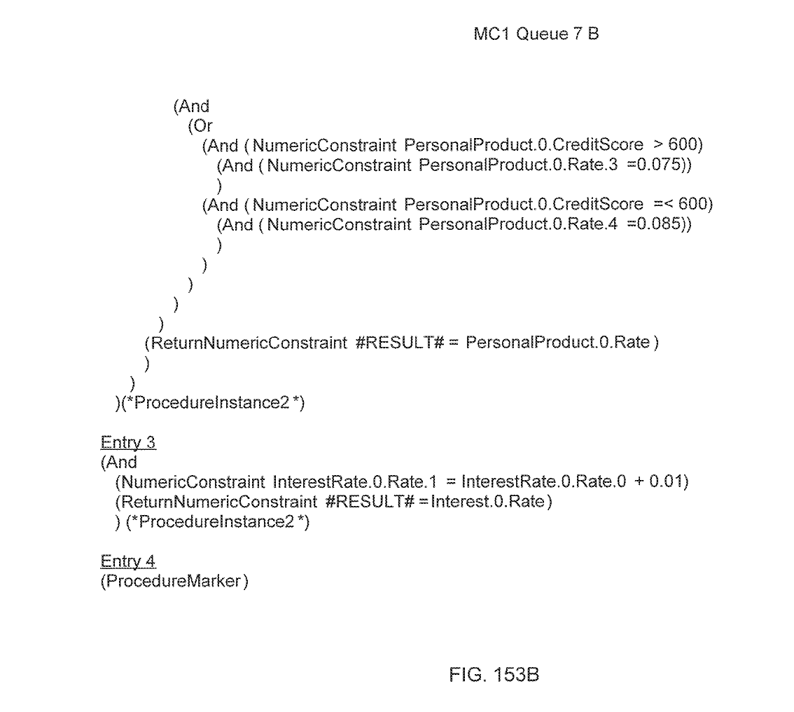

The new state of the Term Queue is illustrated in MC1 Queue 7 (FIGS. 153A-153B).
8. Generate Pattern Model for MC1 continues. It removes the first term in Term-Queue, and matches it in the “Pattern Model Generation Table” to determine the action.
The “CodeConstraint” row of the table is matched;
The constraint is bound to the appropriate instance, and it is added to the Abstract Model container to show that the procedure has such a data element
The constraint expression itself is converted to a format compatible with Fourier Elimination, and applied to Model's Code Container

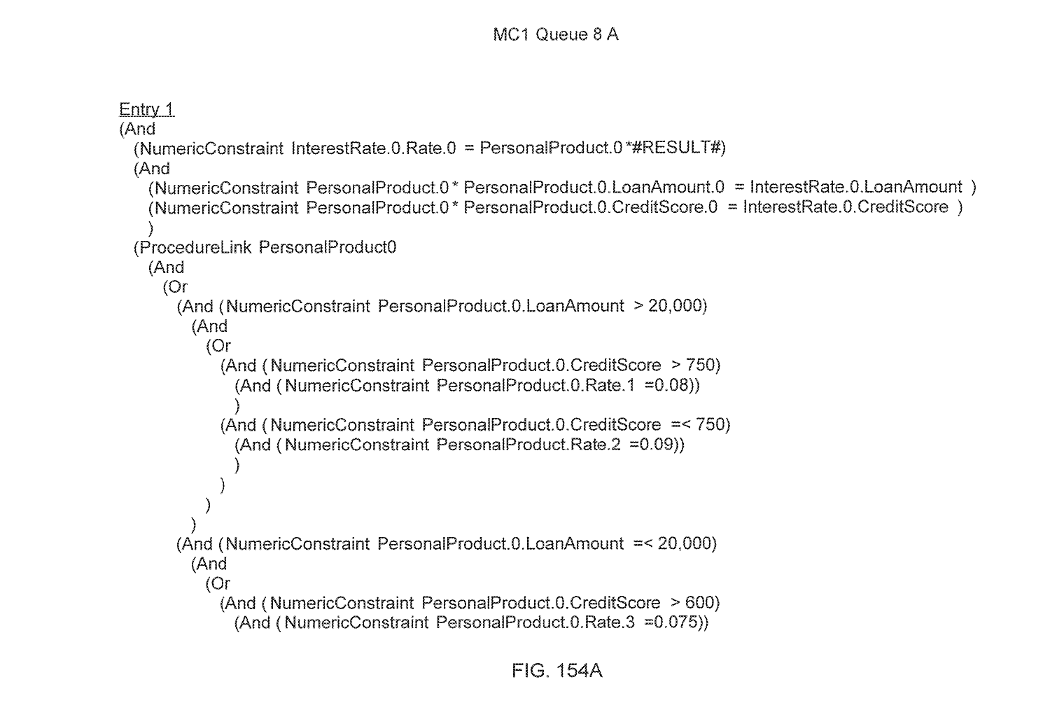

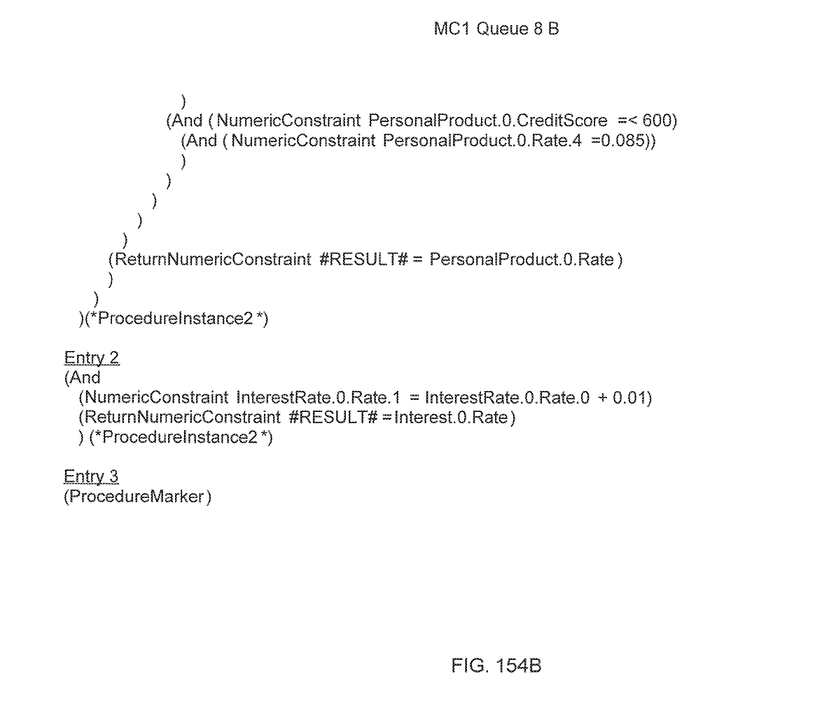

The new state of the model Container is illustrated in MC1 5 (FIG. 274); its Term Queue is illustrated in MC1 Queue 8 (FIGS. 154A-154B).
9. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

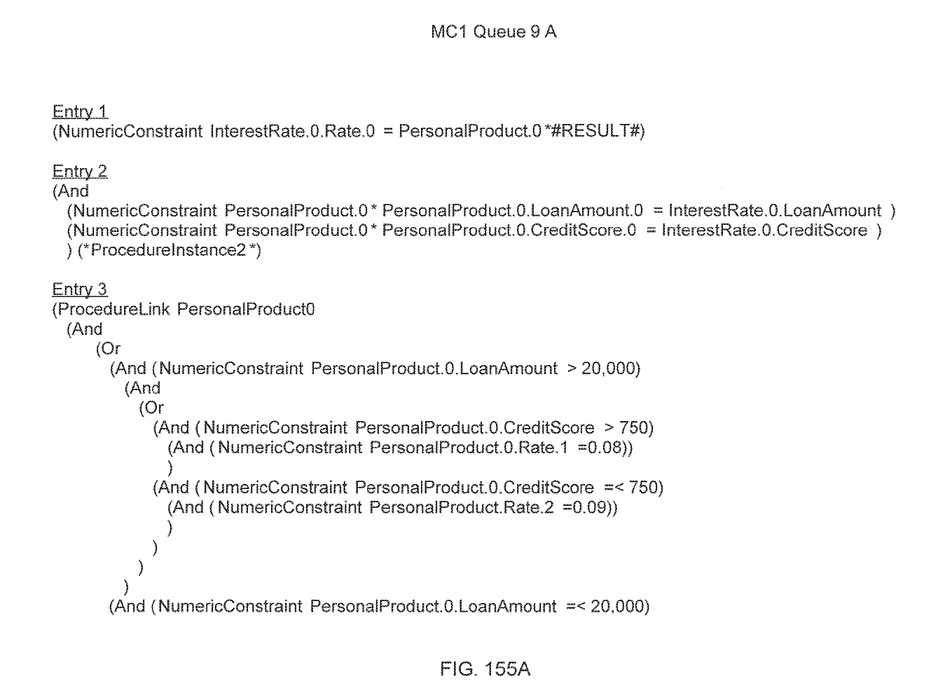

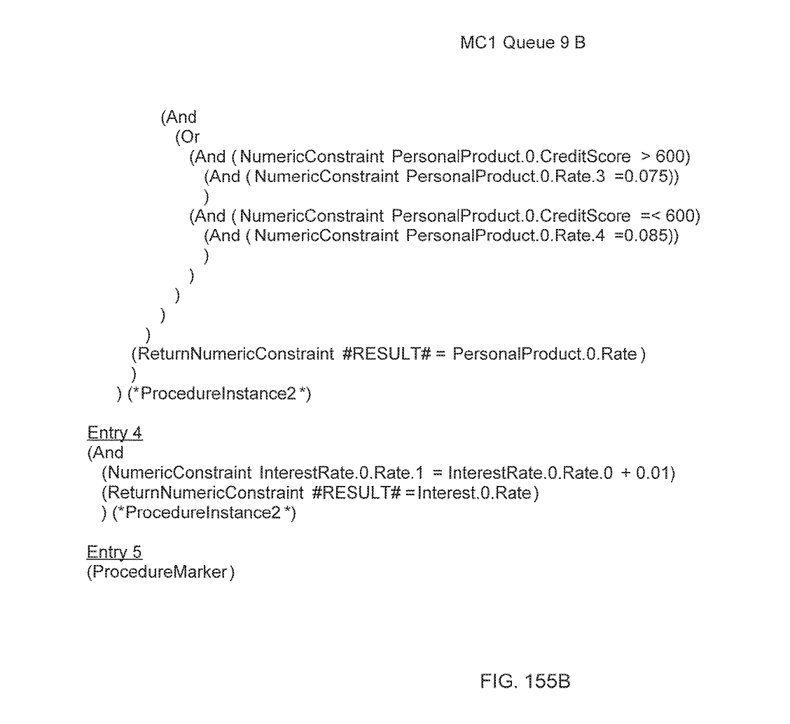

MC1's new Term Queue is illustrated in MC1 Queue 9 (FIGS. 155A-155B).
10. Generate Pattern Model for MC1 continues. It removes the first term in Term-Queue, and matches it in the “Pattern Model Generation Table” to determine the action.
The “NumericConstraint” row of the table is matched;
The constraint is bound to the appropriate instance, and it is added to the Abstract Model container to show that the procedure has such a data element
The constraint expression itself is applied to the Model's Numeric Container

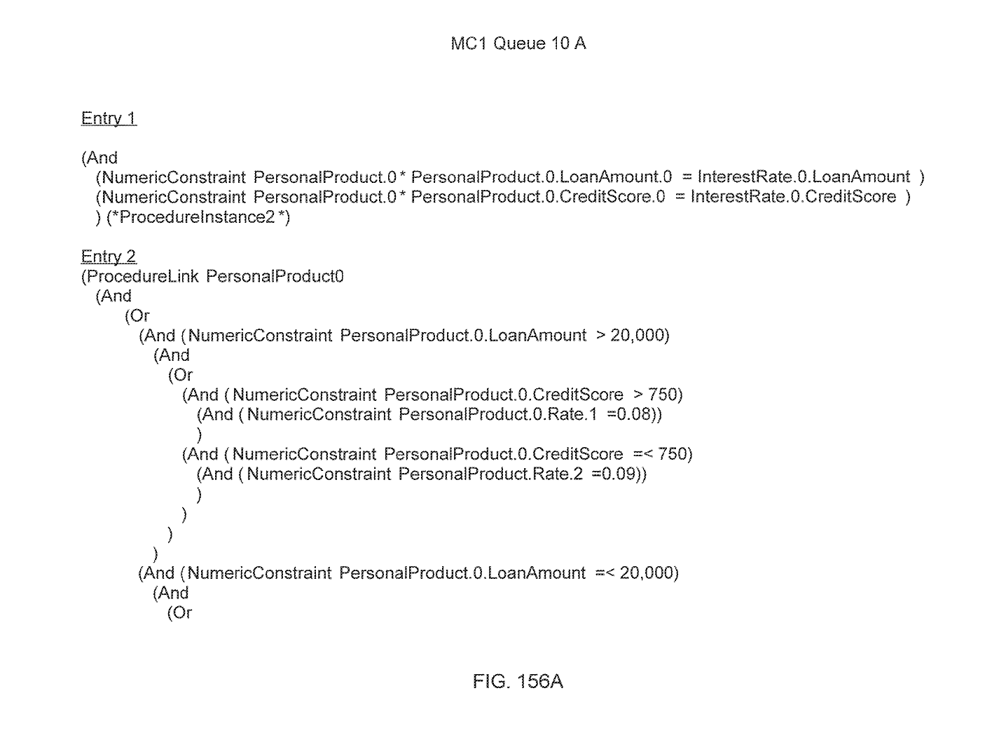

The new state of the Model Container is illustrated in MC1 6 (FIG. 146F); its Term Queue is illustrated in MC1 Queue 10 (FIGS. 156A-156B).
11. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

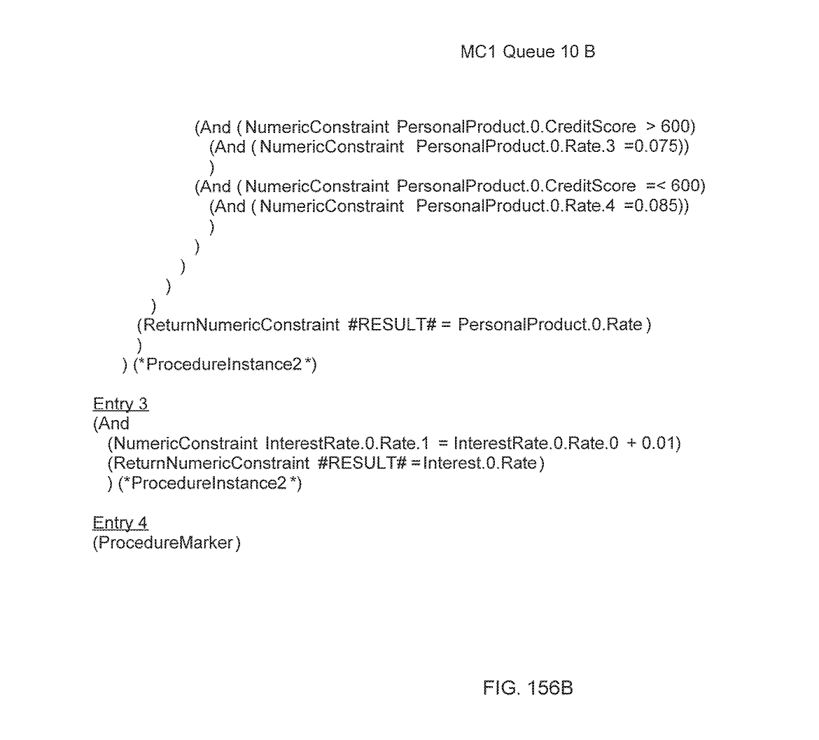

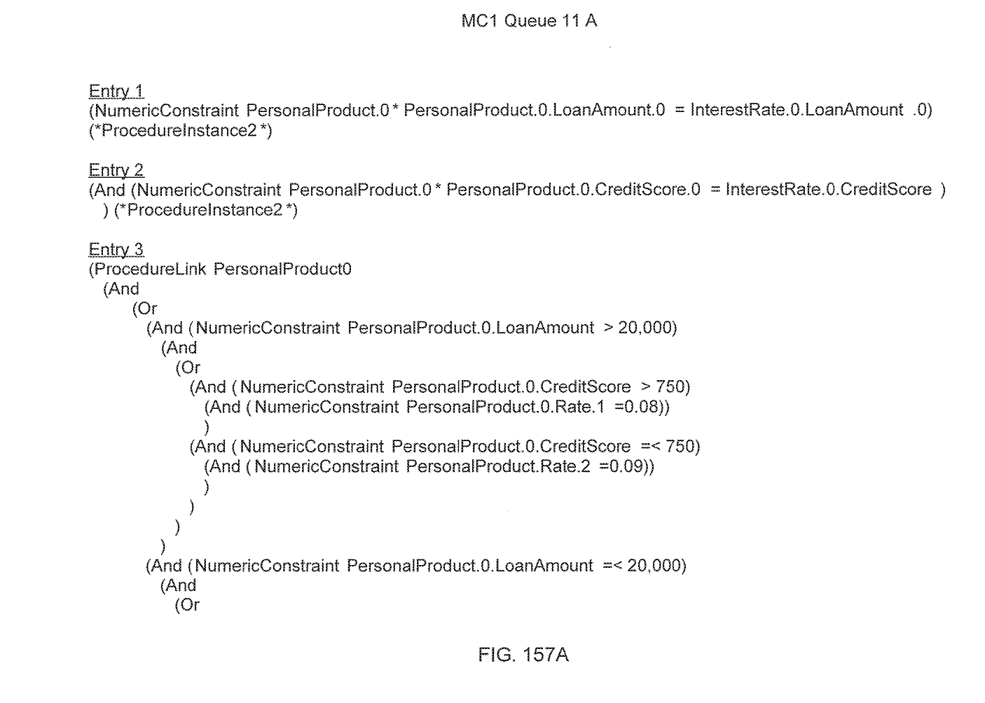

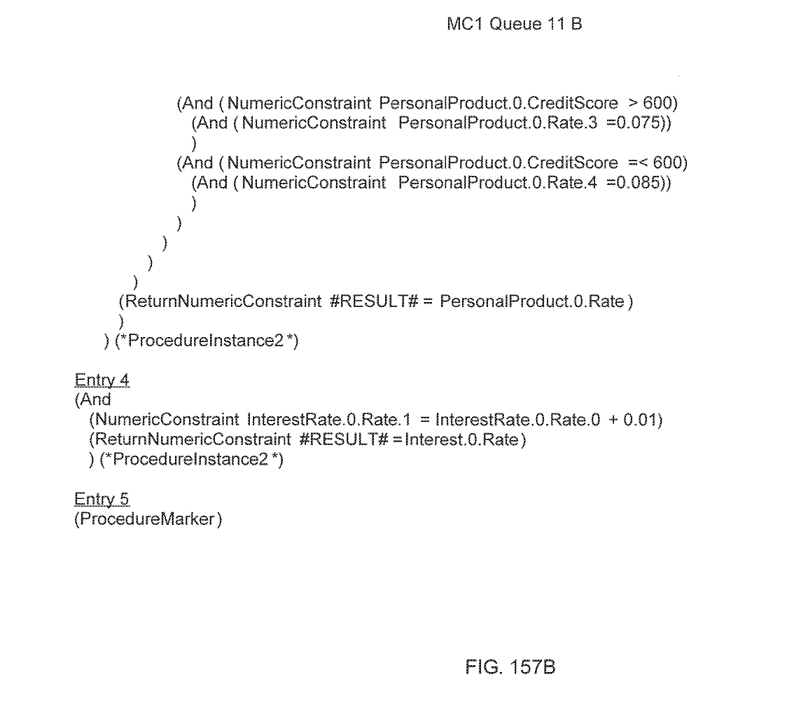

MC1's new Term Queue is illustrated in MC1 Queue 11 (FIGS. 157A-157B).
12. Generate Pattern Model for MC1 continues. It removes the first term in Term-Queue, and matches it in the “Pattern Model Generation Table” to determine the action.
The “NumericConstraint” row of the table is matched;
The constraint is bound to the appropriate instance, and it is added to the Abstract Model container to show that the procedure has such a data element
The constraint expression itself is applied to the Model's Numeric Container

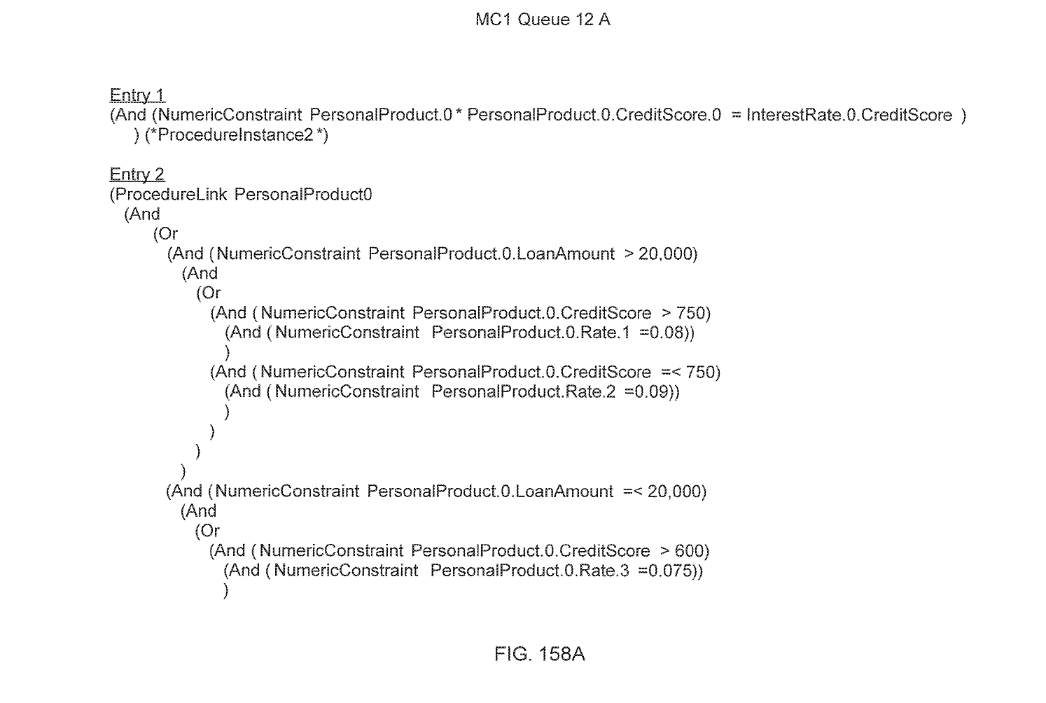

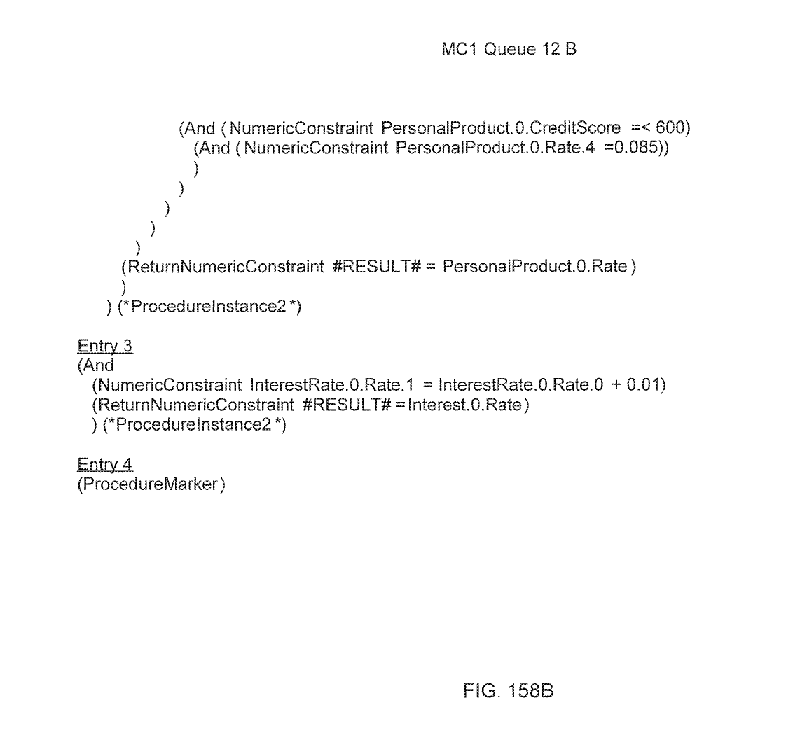

The new state of the Model Container is illustrated in MC1 7 (FIG. 146G); its Term Queue is illustrated in MC1 Queue 12 (FIGS. 158A-158B).
13. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
There is no second sub-expression, so no new “And” is added.

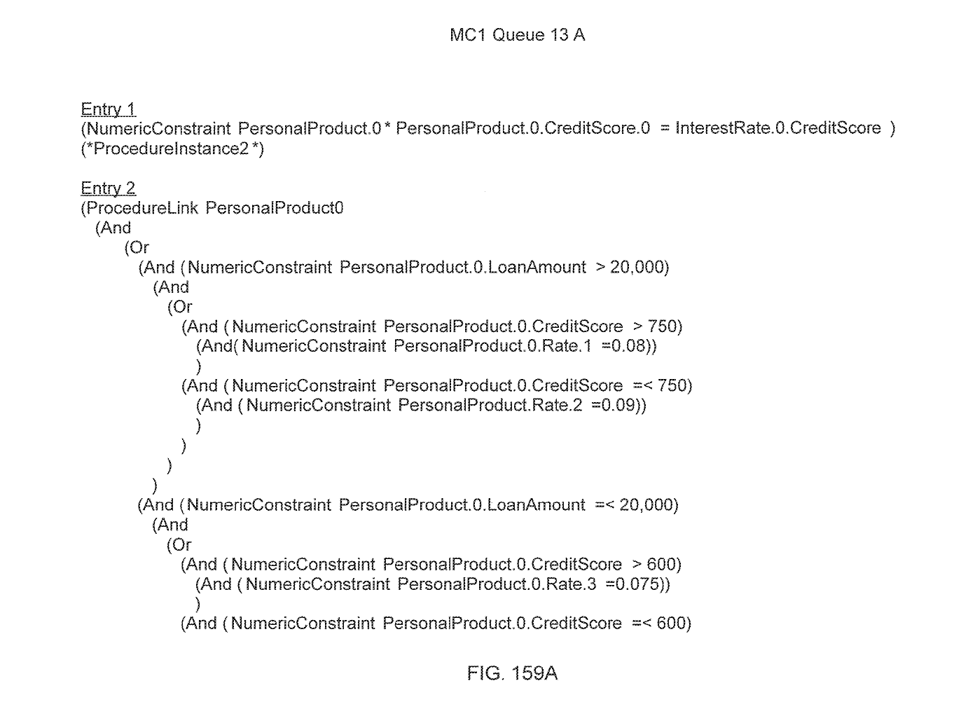

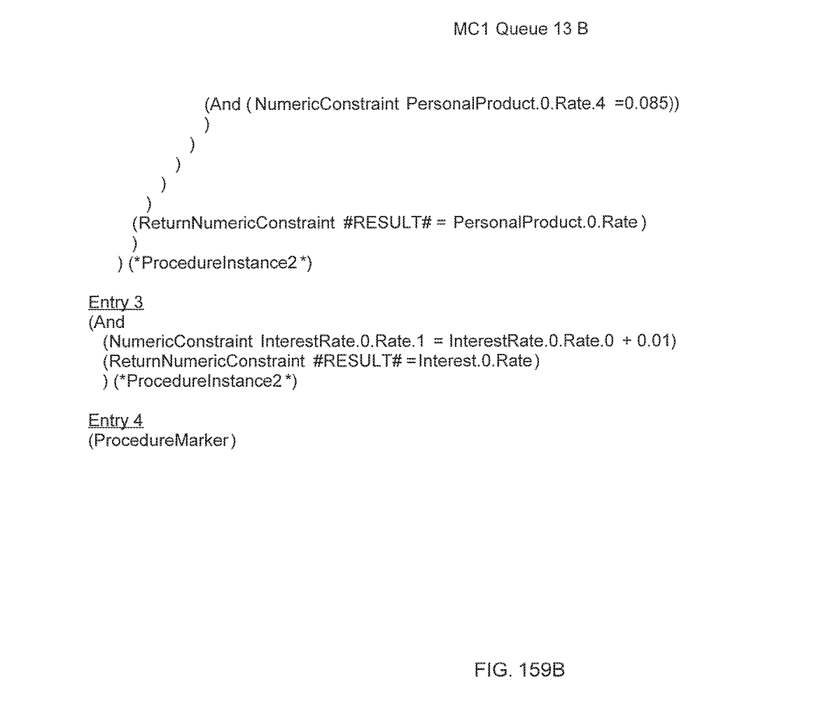

MC1's new Term Queue is illustrated in MC1 Queue 13 (FIGS. 159A-159B).
14. Generate Pattern Model for MC1 continues. It removes the first term in Term-Queue, and matches it in the “Pattern Model Generation Table” to determine the action.
The “NumericConstraint” row of the table is matched;
The constraint is bound to the appropriate instance; and it is added to the Abstract Model container to show that the procedure has such a data element
The constraint expression itself is applied to the Model's Numeric Container

The new state of the Model Container is illustrated in MC1 8 (FIG. 146H); its Term Queue is illustrated in MC1 Queue 14 (FIGS. 106A-106B).
15. Generate Pattern Model continues. It removes the first term in Term-Queue, and matches it in the “Pattern Model Generation Table” to determine the action.
The “ProcedureLink” row of the table is matched;
The procedure instance for the PersonalProduct call has already been allocated in the previous step
A ProcedureFeature term is asserted to represent the link from the entry procedure and the sub-procedure has already been asserted in the previous step
A Procedure Call marker is asserted, to mark the invocation point in the Term Queue
A term is created and asserted to the Term Queue using the procedure expression portion of the Procedure Link, and the “new” procedure instance.

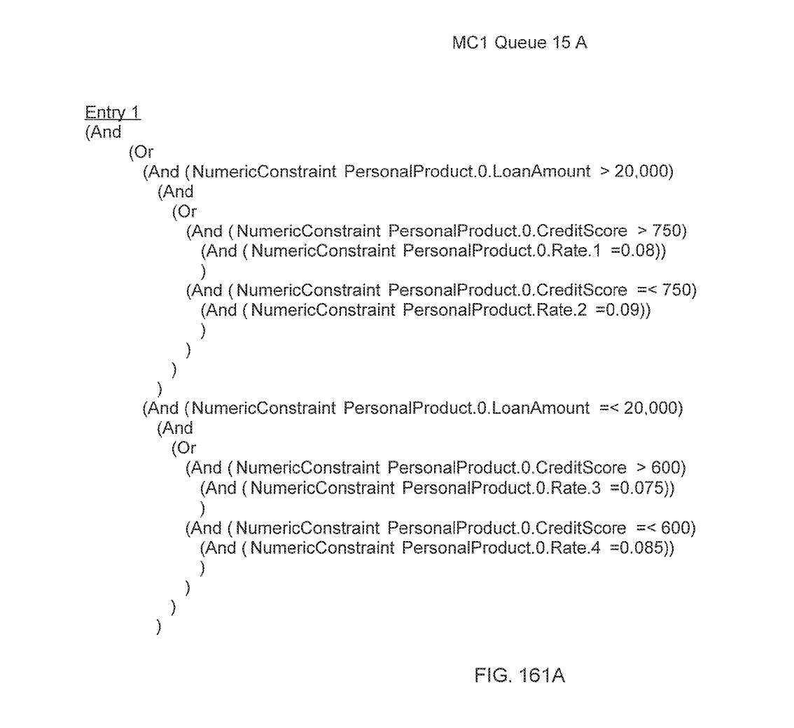

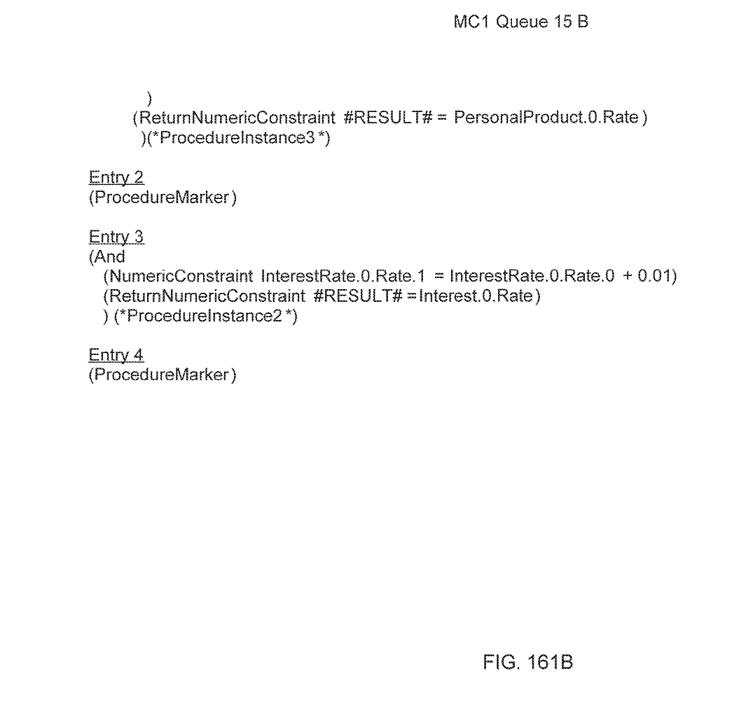

The new state of the Model Container is illustrated in MC1 9 (FIG. 146I); its Term Queue is illustrated in MC1 Queue 15 (FIGS. 161A-161B).
16. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

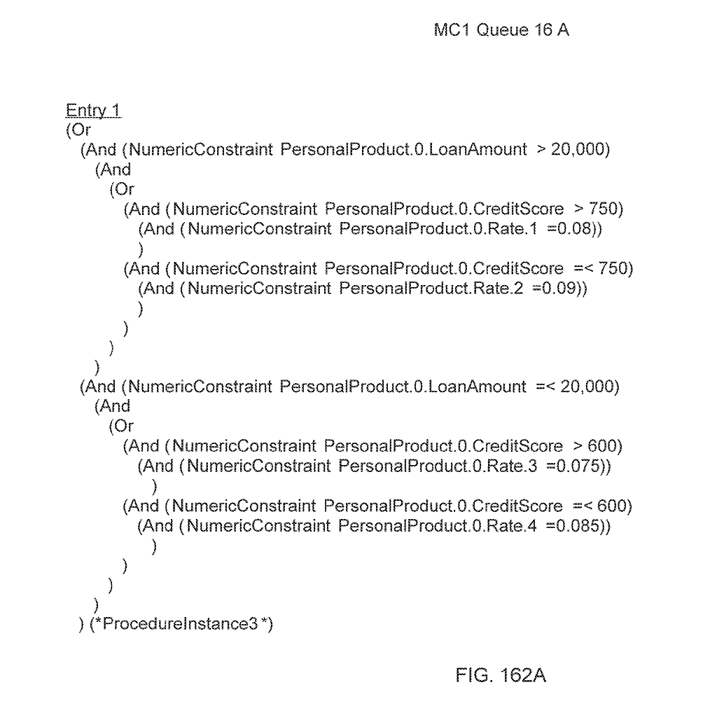

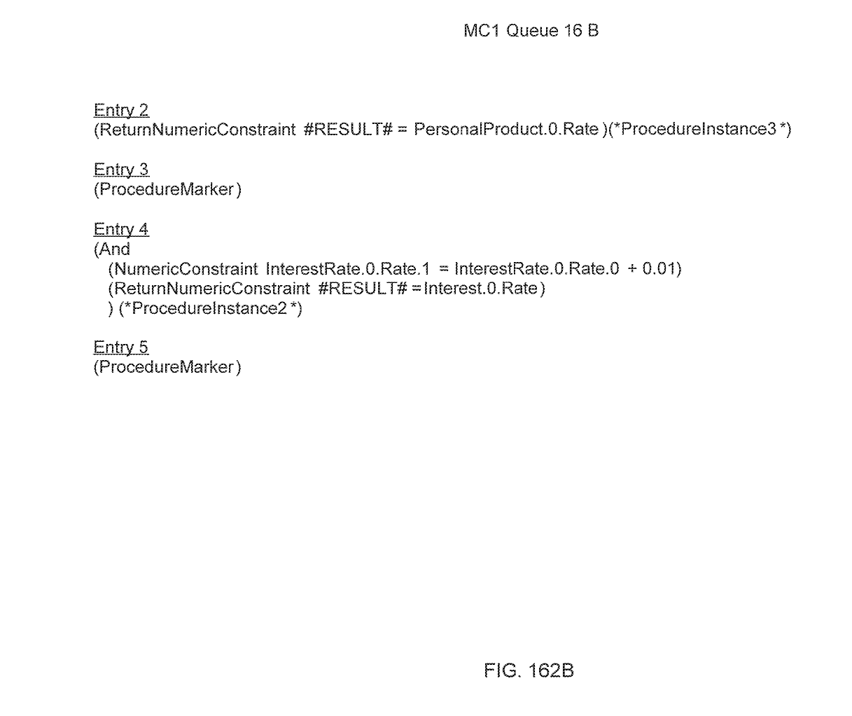

MC1's new Term Queue is illustrated in MC1 Queue 16 (FIGS. 162A-162B).
17. Generate Pattern Model continues. It removes the first term in Term-Queue, and matches it in the “Pattern Model Generation Table” to determine the action.
The “Or” row of the table is matched.
A new Model Container named “MC3” is created by cloning the MC1.
The first sub-expression is added to the front of the Term Queue of the original Model Container MC1.
The second sub-expression is added to the front of the Term Queue of MC3.
MC3 is added to the Input Queue of the Model Generator MG2.

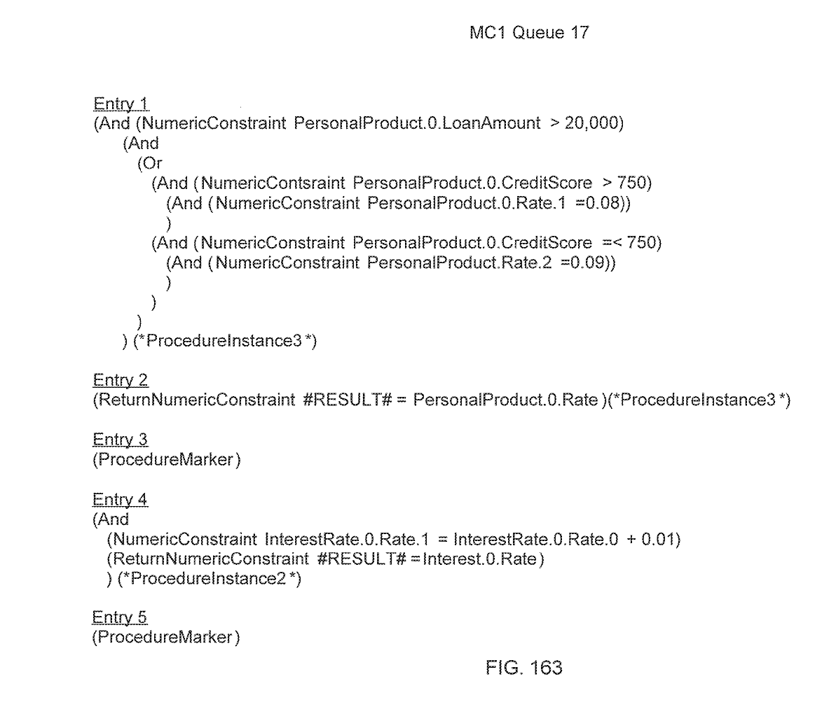

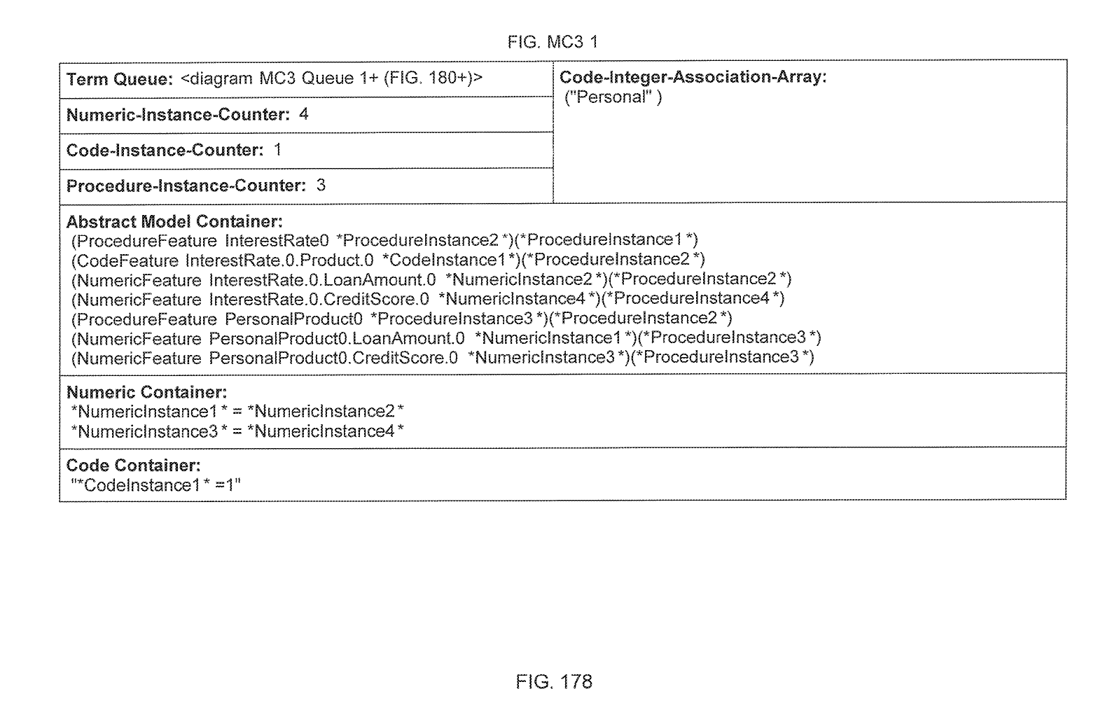

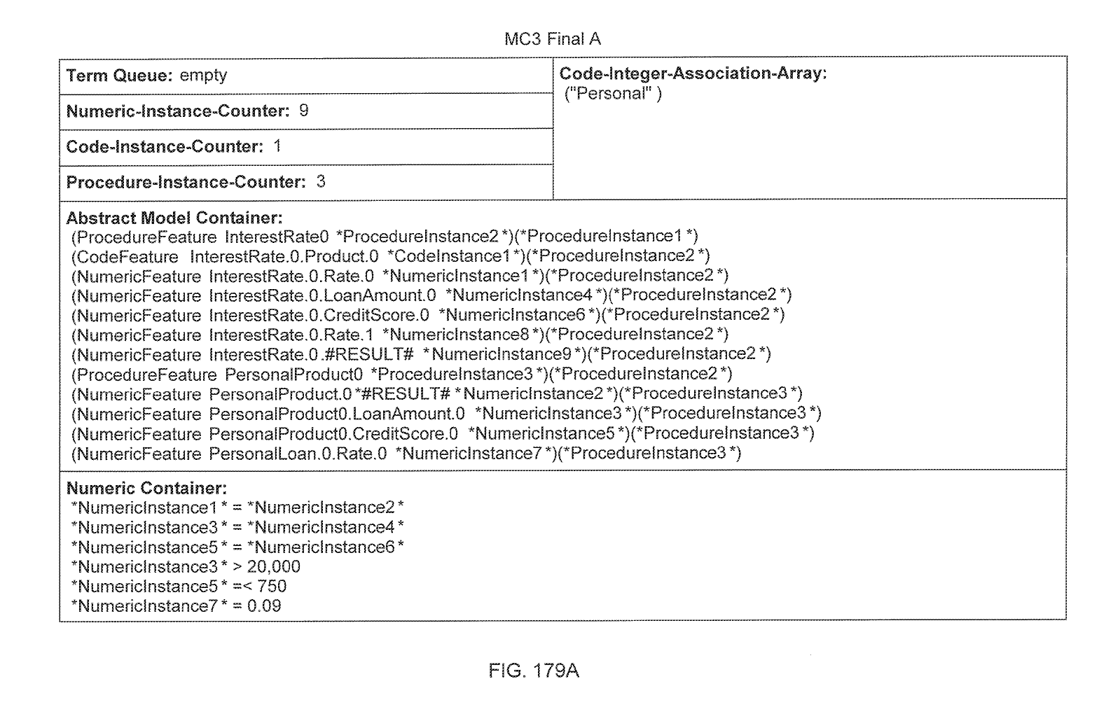

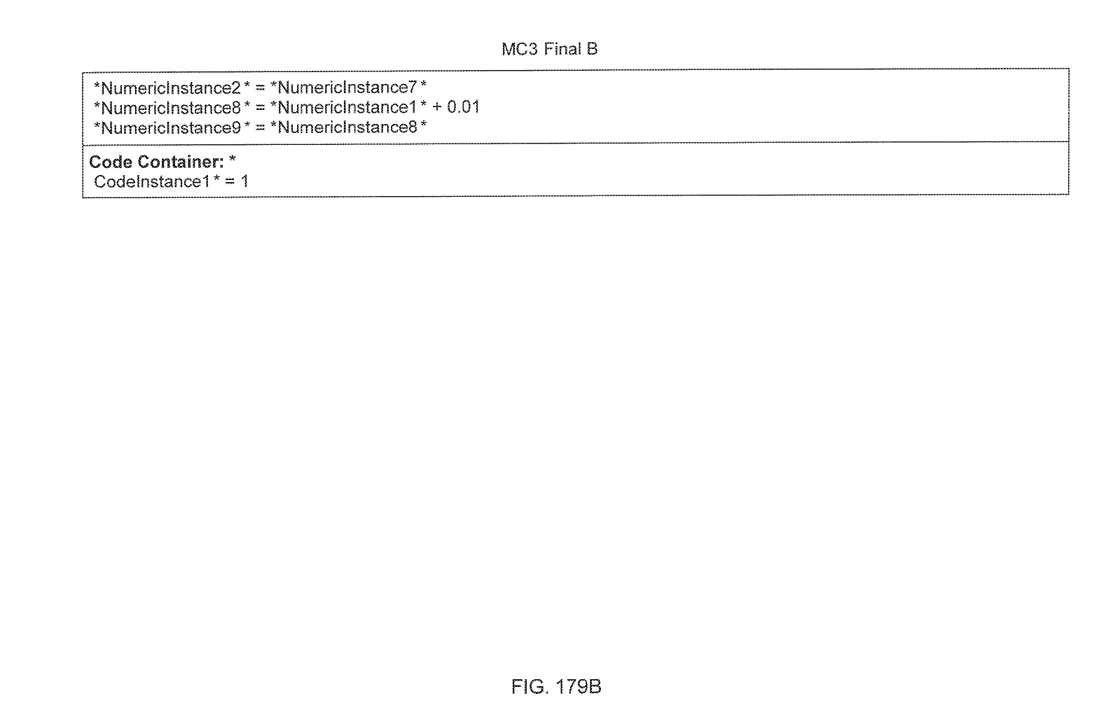

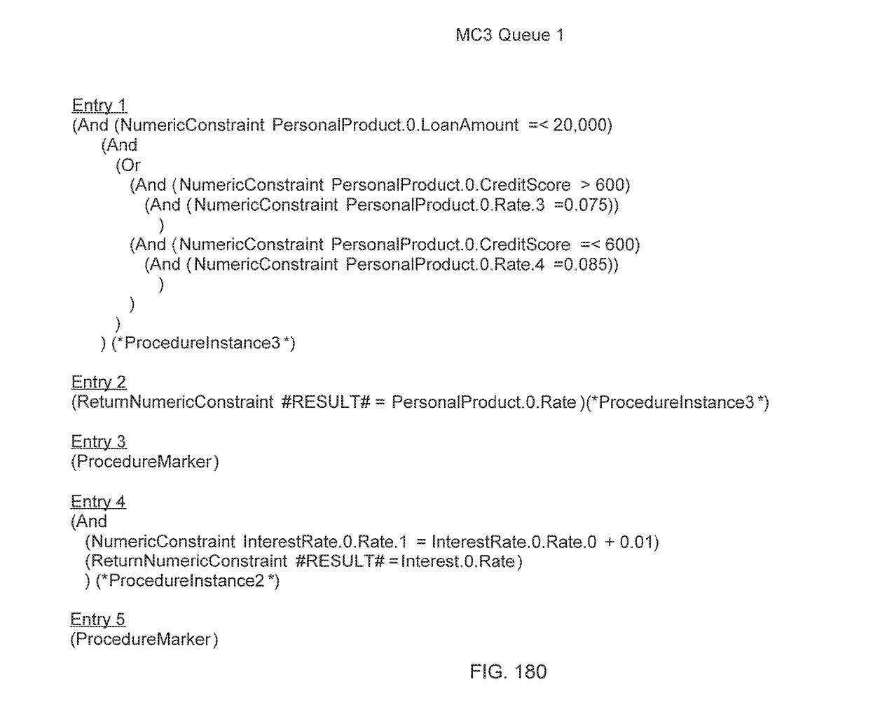

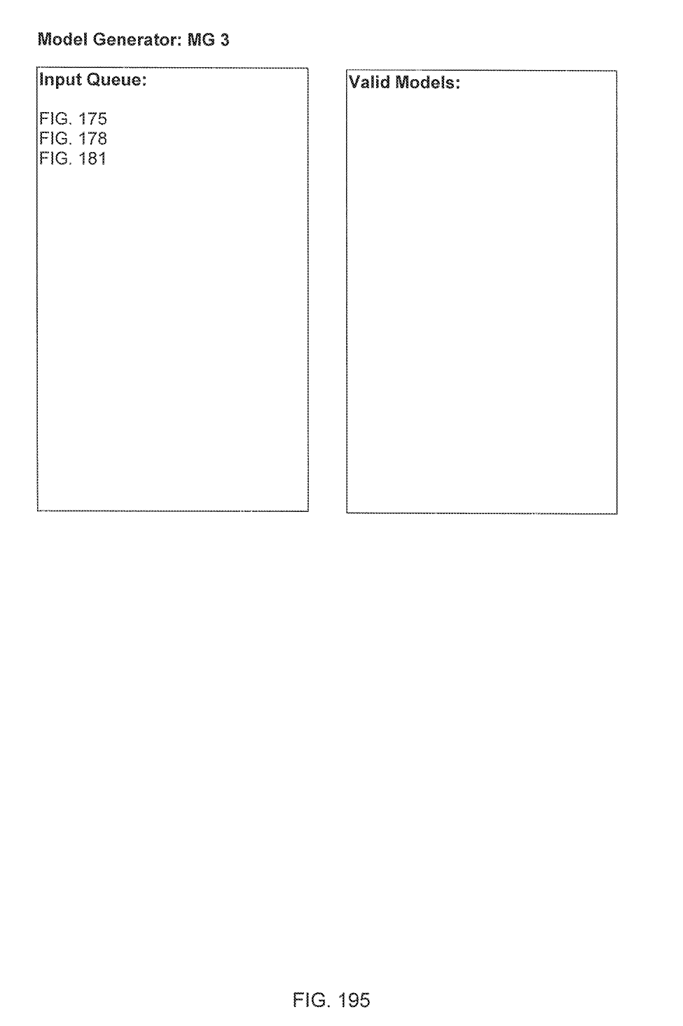

The new state of the Term Queue is illustrated in MC1 Queue 17 (FIG. 163). The new Model Container MC3 is illustrated in diagram MC3 1 (FIG. 178). The state of MC3's queue is illustrated in diagram MC3 Queue 1 (FIG. 180). The new state of the Model Generator is illustrated in diagram MG3 (FIG. 195).
18. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

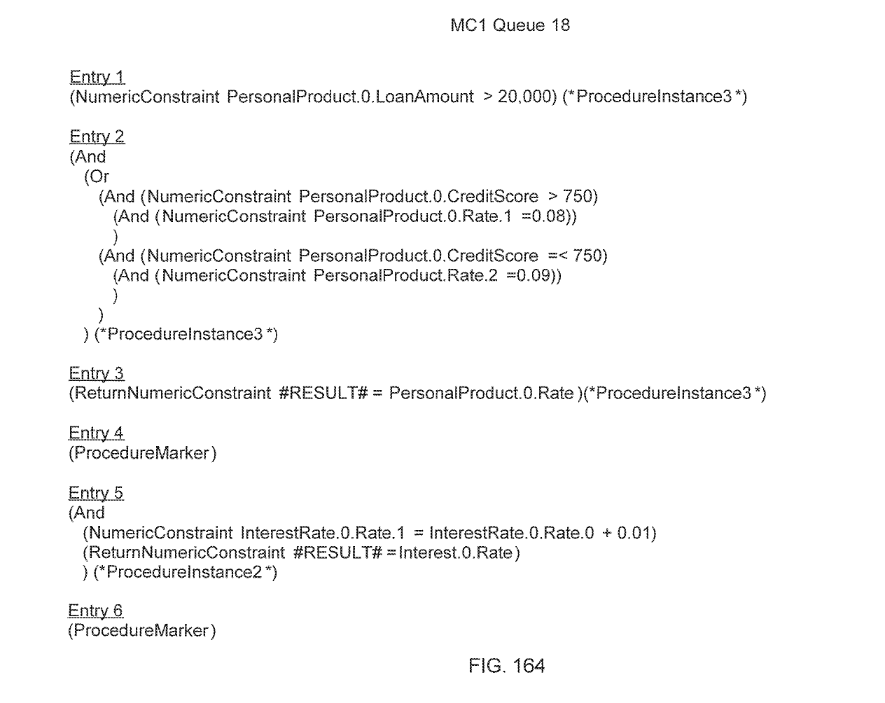

MC1's new Term Queue is illustrated in MC1 Queue 18 (FIG. 164).
19. Generate Pattern Model for MC1 continues. It removes the first term in Term-Queue, and matches it in the “Pattern Model Generation Table” to determine the action.
The “NumericConstraint” row of the table is matched;
The constraint is bound to the appropriate instance;
The constraint expression itself is applied to the Model's Numeric Container.

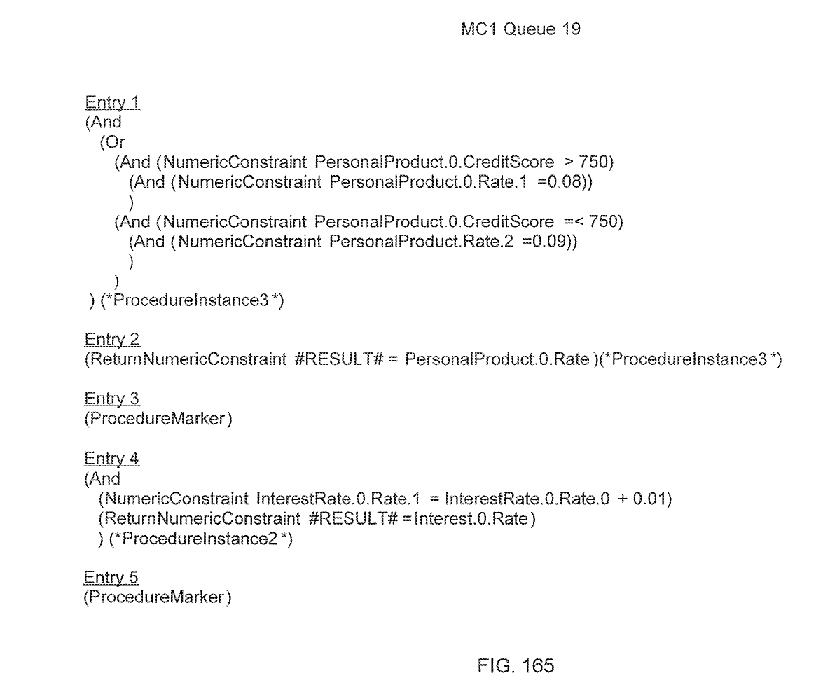

The new state of the Model Container is illustrated in MC1 10 (FIG. 146J); its Term Queue is illustrated in MC1 Queue 19 (FIG. 165).
20. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

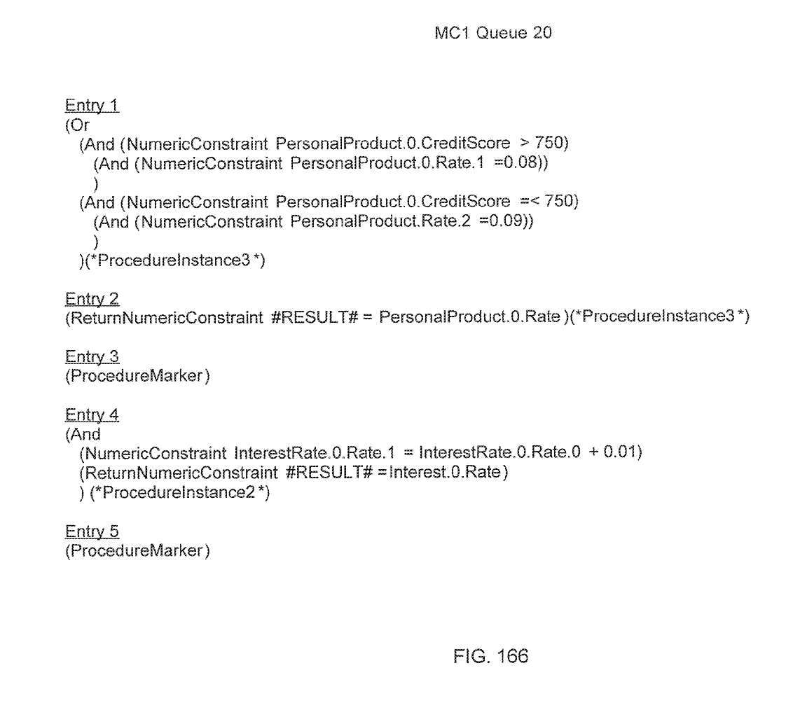

MC1's new Term Queue is illustrated in MC1 Queue 20 (FIG. 166).
21. Generate Pattern Model continues. It removes the first term in Term-Queue, and matches it in the “Pattern Model Generation Table” to determine the action.
The “Or” row of the table is matched;
A new Model Container named “MC4” is created by cloning the MC1.
The first sub-expression is added to the front of the Term Queue of the original Model Container MC1
The second sub-expression is added to the front of the Term Queue of MC4 MC4 is added to the Input Queue of the Model Generator MG3

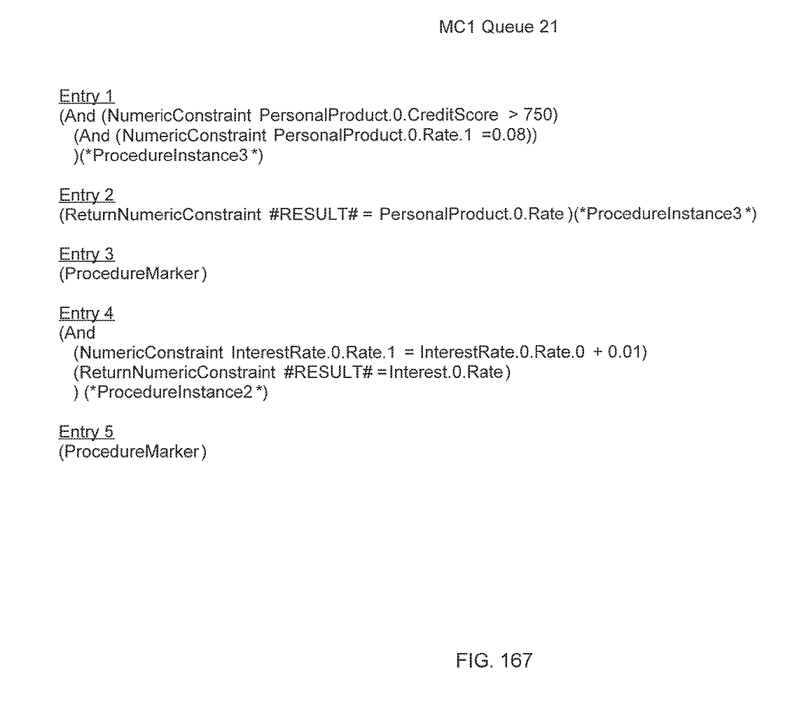

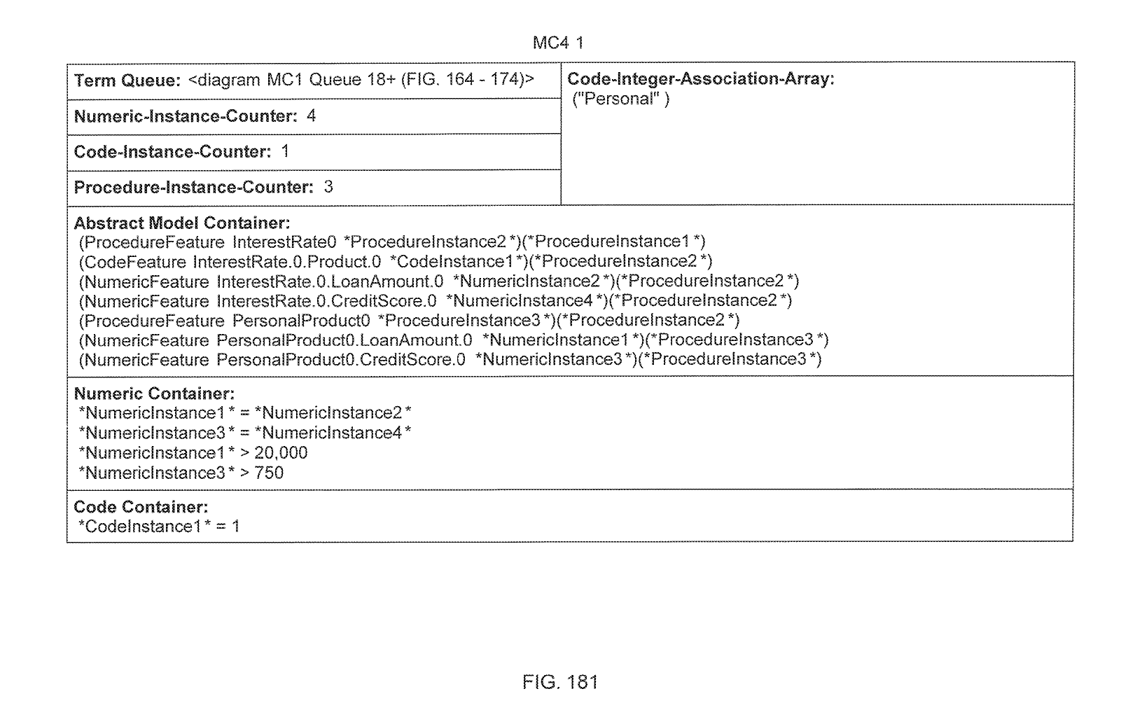

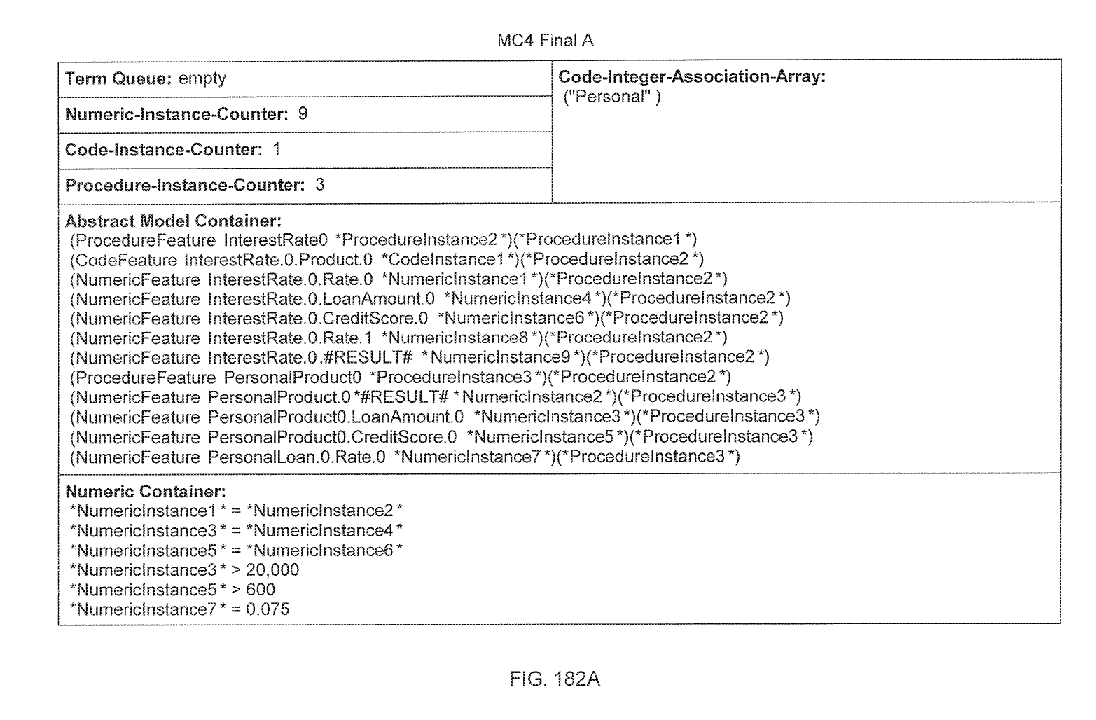

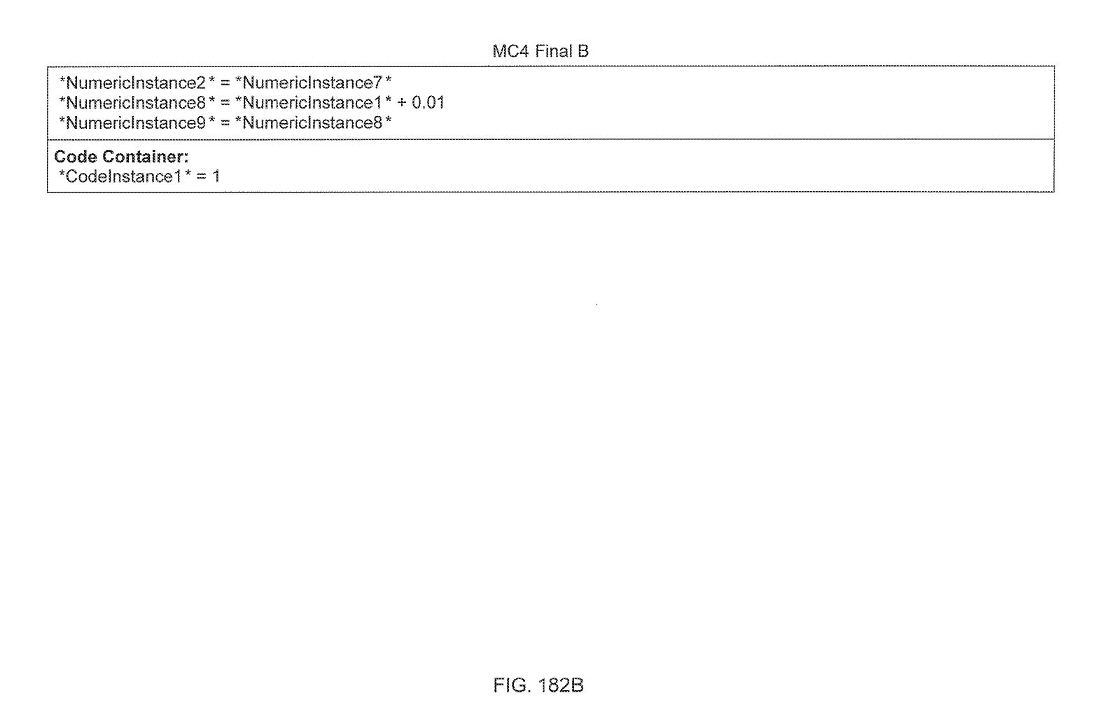

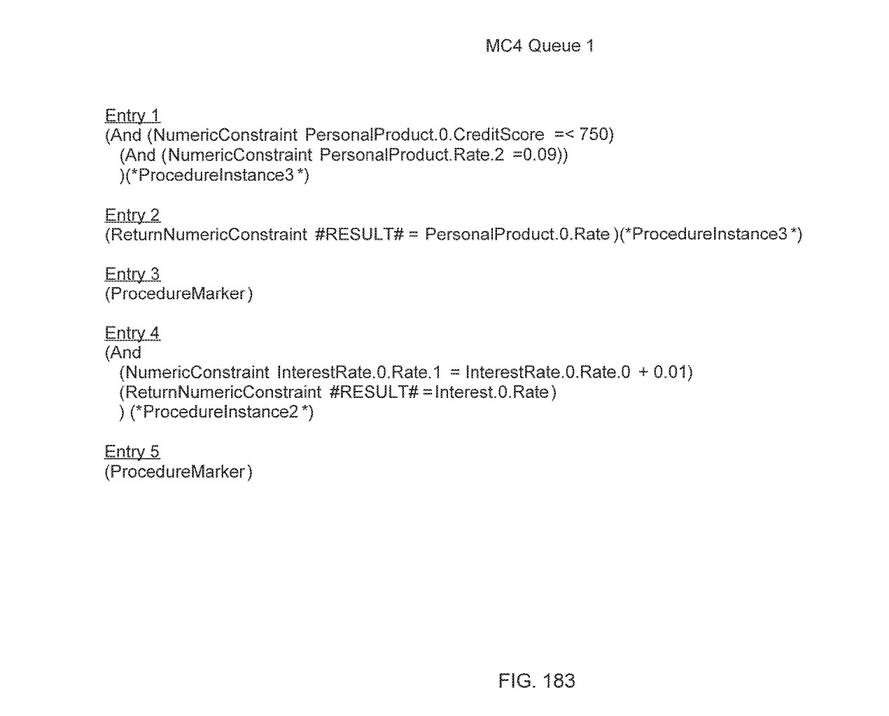

The new state of the Term Queue is illustrated in MC1 Queue 21 (FIG. 167). The new Model Container MC4 is illustrated in diagram MC4 1 (FIG. 181). The state of MC4's queue is illustrated in diagram MC4Queue 1 (FIG. 183). The new state of the Model Generator is illustrated in diagram MG4 (FIG. 196).
22. Generate Pattern Model for MC1 continues: It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

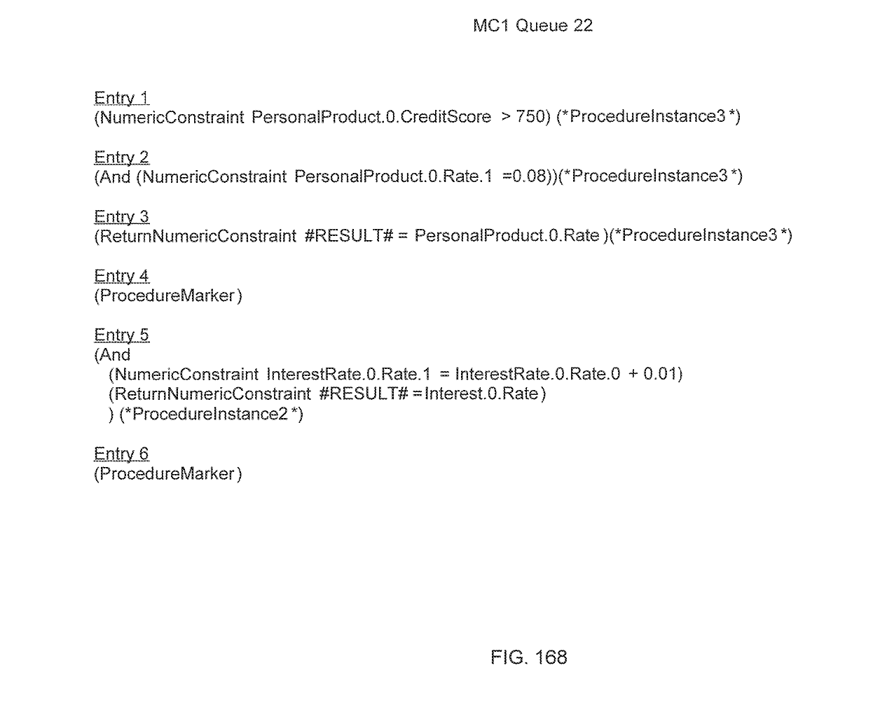

MC1's new Term Queue is illustrated in MC1 Queue 22 (FIG. 168).
23. Generate Pattern Model for MC1 continues: It removes the first term in Term-Queue, and matches it in the “Pattern Model Generation Table” to determine the action.
The “NumericConstraint” row of the table is matched;
The constraint is bound to the appropriate instance
The constraint expression itself is applied to the Model's Numeric Container

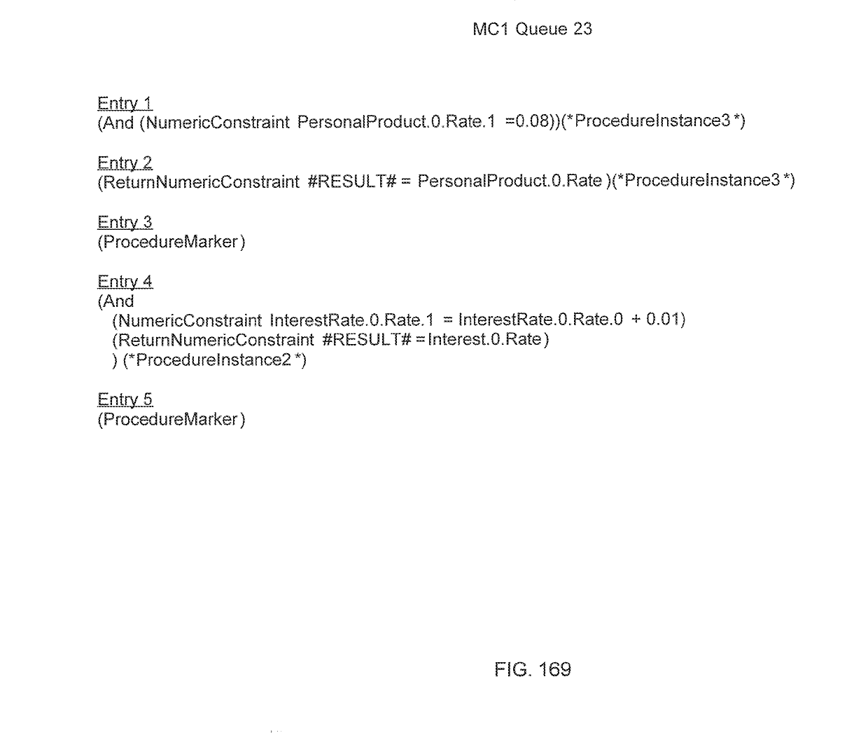

The new state of the Model Container is illustrated in MC1 11 (FIG. 146K); its Term Queue is illustrated in MC1 Queue 23 (FIG. 169).
24. Generate Pattern Model for MC1 continues. It removes the first term in Term-Queue, and matches it in the “Pattern Model Generation Table” to determine the action.
The “NumericConstraint” row of the table is matched;
The constraint is bound to the appropriate instance; and it is added to the Abstract Model container to show that the procedure has such a data element
The constraint expression itself is applied to the Model's Numeric Container

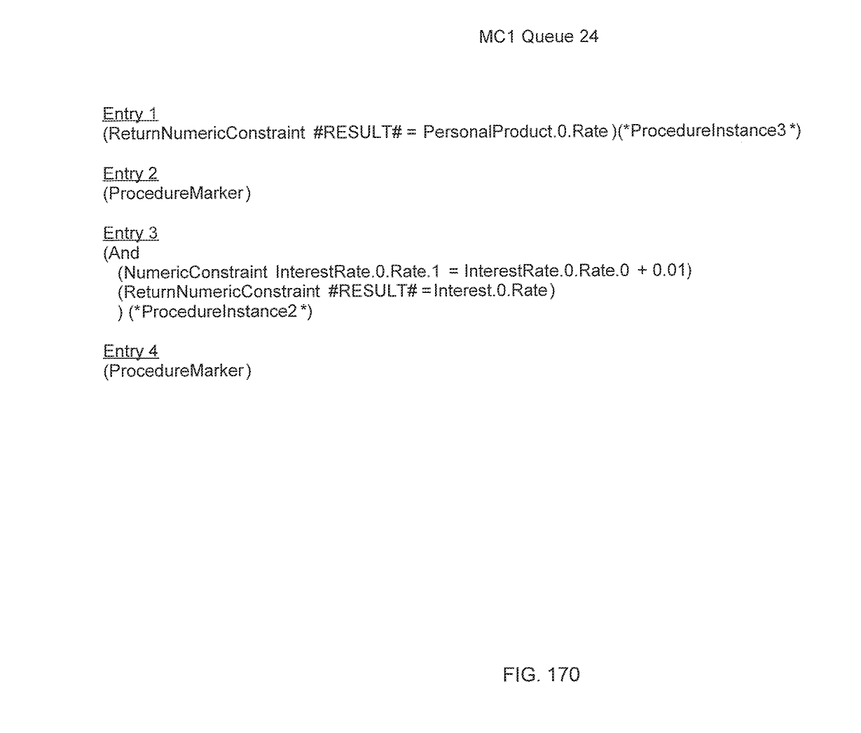

The new state of the model Container is illustrated in MC1 12 (FIG. 146L); its Term Queue is illustrated in MC1 Queue 24 (FIG. 170).
25. Generate Pattern Model for MC1 continues. It removes the first term in Term-Queue, and matches it in the “Pattern Model Generation Table” to determine the action.
The “ReturnNumericConstraint” row of the table is matched;
The constraint is bound to the appropriate instance, specifically the last data element state for the “rate” variable;
The resulting constraint expression itself is applied to the Model's Numeric Container
The Term Queue is “popped” until a procedure is met

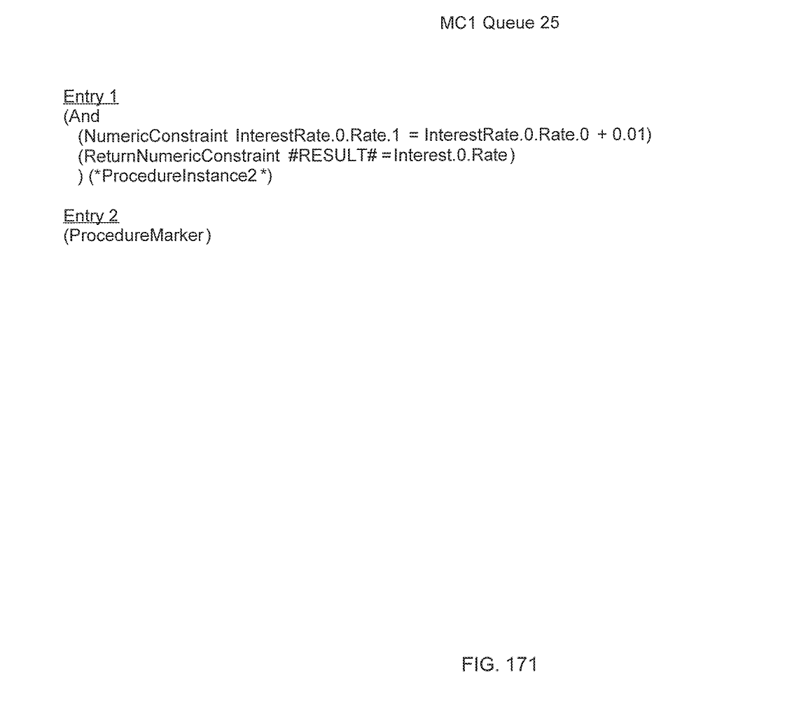

The new state of the Model Container is illustrated in MC1 13 (FIG. 146M); its Term Queue is illustrated in MC1 Queue 25 (FIG. 171).
26. Generate Pattern Model for MC1 continues. It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
A new “And” is created from the remaining sub-expressions and a term is created using the same instance, and asserted to the second position of the Term Queue.

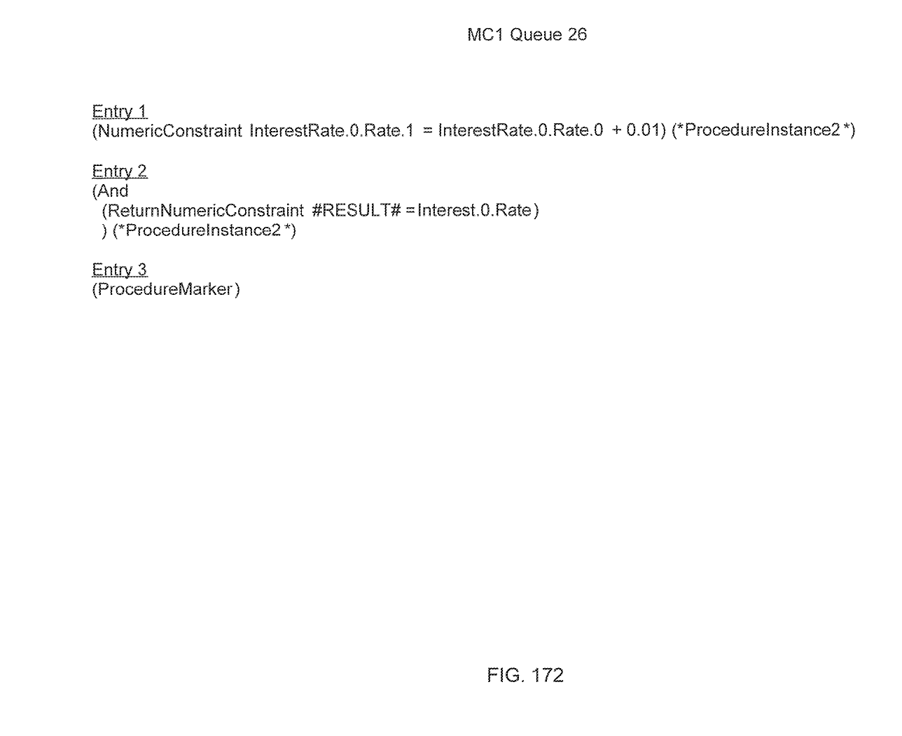

MC1's new Term Queue is illustrated in MC1 Queue 26 (FIG. 172).
27. Generate Pattern Model for MC1 continues: It removes the first term in Term-Queue, and matches it in the “Pattern Model Generation Table” to determine the action.
The “NumericConstraint” row of the table is matched;
The constraint is bound to the appropriate instance, and it is added to the Abstract Model container to show that the procedure has such a data element. Note that this creates another “state data element” for variable Rate, since it is the second assignment to that variable
The constraint expression itself is applied to the Model's Numeric Container

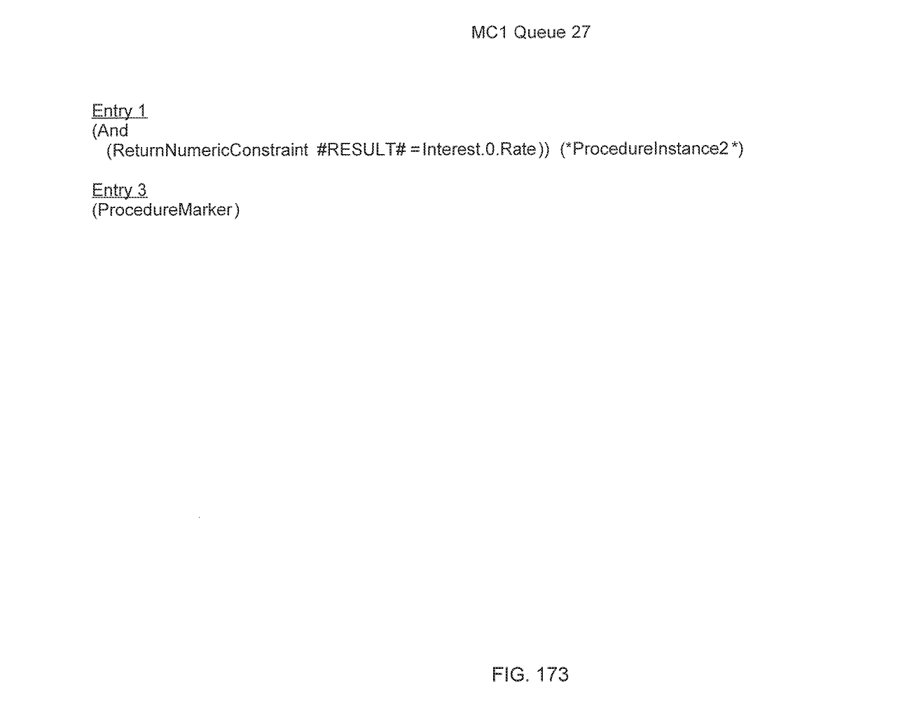

The new state of the model Container is illustrated in MC1 14 (FIG. 146NA-146 NB); its Term Queue is illustrated in MC1 Queue 27 (FIG. 173).
28. Generate Pattern Model for MC1 continues: It removes the first term in Term-Queue, and matches it in the “Pattern Model Generation Table” to determine the action.
The “And” row of the table is matched;
The new term with the same instance is created from the first sub-expression of the “And” and asserted to the first position of the Term Queue;
There is no second sub-expression, so none is added.

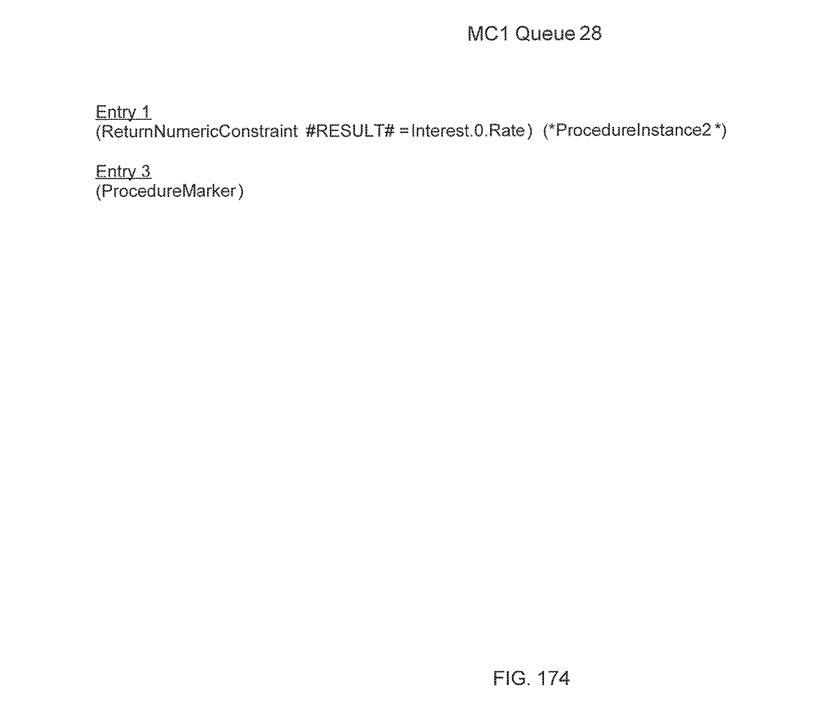

MC1's new Term Queue is illustrated in MC1 Queue 28 (FIG. 174).
29. Generate Pattern Model for MC1 continues: It removes the first term in Term-Queue, and matches it in the “Pattern Model Generation Table” to determine the action.
The “ReturnNumericConstraint” row of the table is matched;
The constraint is bound to the appropriate instance, specifically the last data element state for the “rate” variable;
The resulting constraint expression itself is applied to the Model's Numeric Container;
The Term Queue is “popped” until a procedure is met.

The new state of the Model Container is illustrated in MC1 15 (FIGS. 1460A-146OB); its Term Queue is now empty. The empty queue indicates the pattern model is complete, and it returns to the “Generate All Patterns.”
30. Generate All Patterns takes the result complete model and tests it for validity by calling Is Model Valid.
Is Consistent (described in the Fourier Elimination section) is called with the Numeric Container from MC1 15, and is found to be consistent, therefore valid;
Is Consistent is called with the Code Container from MC1 15, and is found to be consistent, therefore valid;
Consequently, MC1 is valid.

Control returns to Generate All Patterns, which adds the Model Container to the Valid Model set in the Model Generator. This is illustrated in MG4 (FIG. 196).

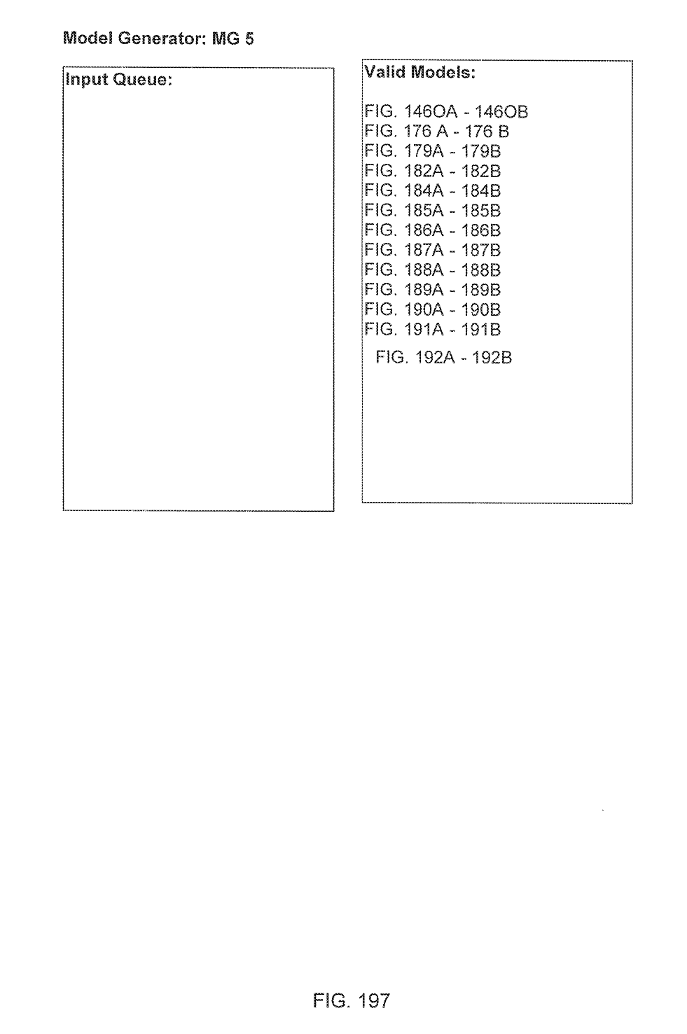

The detailed portion of this example stops with the generation of the MC1 series, but there are other models (MC2, MC3, MC4) to be completed and validated. These models in turn spawn other models. The final state of the Model Generator is illustrated in MG5 (FIG. 197). There are thirteen valid pattern models; the corresponding Model Containers are MC1 through MC13 and are illustrated in the MC# Final diagrams.

Fourier Elimination

Fourier Elimination is an algorithm for solving systems of linear equations. It is used for two purposes in this example. The first purpose is to confirm that the set of numeric expressions associated with a code path is consistent, i.e., it does not lead to contradiction. The requirement that the data model of a code path be consistent is discussed at length in the model generation section above.

The second purpose is to “project” on a variable to determine its value. This is tantamount to determining the possible values that a data element can validly take in a particular input-output model. This, too, is discussed at length in the model generation section above.

Algorithm Intuition

All elimination algorithms are quite similar to the methods taught to first-year algebra students in middle or high school. One solves a system of equations by isolating variables and eliminating them by substitution of other equations. This is methodologically illustrated below, both with flow charts (for the algorithms) and data flow charts (for the examples)

Mathematical Formalism

Adopting for a moment the language of mathematics, this elimination algorithm determines whether there is a “feasible region” for the system of inequalities and equalities. The existence of a “feasible region” means that a solution exists. The algorithms process is one of eliminating variables by “projecting” their effect on the remaining variables. This process of “projection” is very familiar all who recollect first year algebra. For inequalities, the process is quite similar but less familiar to most people, since the concept of determining a “feasible region” for inequalities is less obviously relevant to secondary school students.

Using repeated projections, via variable elimination, consistency is determined by the remaining literal expressions. If they are all valid, then a feasible region exists.

When the purpose is projection, one merely projects on the desired variable, in essence, eliminating all variables except the one upon which the projection is focusing. Thus the application's “consistency” and “projection” are merely slightly different applications of the same processes. This fact is reflected below.

Process Format

The processes that comprise this elimination algorithm are defined as conceptual flowcharts, with inputs and outputs. One can think of the inputs as arguments to a block-structured procedure, and the outputs as the return value of the same procedure. Implementation in the reader's language of choice should be straightforward from these descriptions.

Variable Format

Note that in the discussion and examples in this section, the traditional algebraic representation of a variable is a symbol, typically a letter. In this example, the symbol is actually a “numeric instance” that has been allocated in the model generation process (see Model Generation section.) In essence, a symbol can take placeholder form; letters are used in the discussion for clarity

Data Format Definitions

The processes in this section use systems of equations and inequalities that combine linear numeric expressions. These are briefly defined below.

A linear numeric expression takes the form of:

B1*X1+B2*X2+ . . . +Bn*Xn+C

In definition, the product B#*X# describes a variable (X#) multiplied by a Real coefficient (B#). There can be zero or more variables in the expression. “C” denotes a single real constant.

Valid examples of numeric expressions are:

10*X+−1*Y+10

10*X+−1*Y+20.01*Z+50.5

55.1

Equations and Inequalities are constructed by combining two linear expressions with an operator in the form of:

<Linear Numeric Expression 1> <op> <Linear Numeric Expression 2>

Valid operators are: =, !=, >=, >, =<, and <; These operators have their typical mathematical meaning.

Valid examples of equations are:

5=10*X+−1*Y+10

10*X+−1*Y+10>10*X+−1*Y+20.01*Z+50.5

55.1=55.1

1>0

Note that the last two examples are referred to as literal equations or inequalities because they contain no variables, only numeric constants. Also note, since the expressions used as input to this algorithm are both equations and inequalities, they are referred to below as “(in)equations” for brevity sake.

Consistent? Process

“Consistent?” is a process that is invoked to test the consistency of a system of equations and inequalities. The process eliminates all variables from the system, reducing it to a system of literal equations and literal inequalities. These are then tested for contradiction. If no contradiction exists, then the original input system is determined to be consistent. If a contradiction is discovered, then the original input system is determined to be inconsistent.

“Consistent?” accepts as input a set of linear equalities and inequalities, and as output returns, true or false. The reader should note that this set is equivalent to a “system” of inequalities and equalities.

Accordingly, two examples are included below to illustrate the two possible outcomes. Each subordinate process also contains the same two examples, so that the flow of each process can be reviewed.

Algorithm

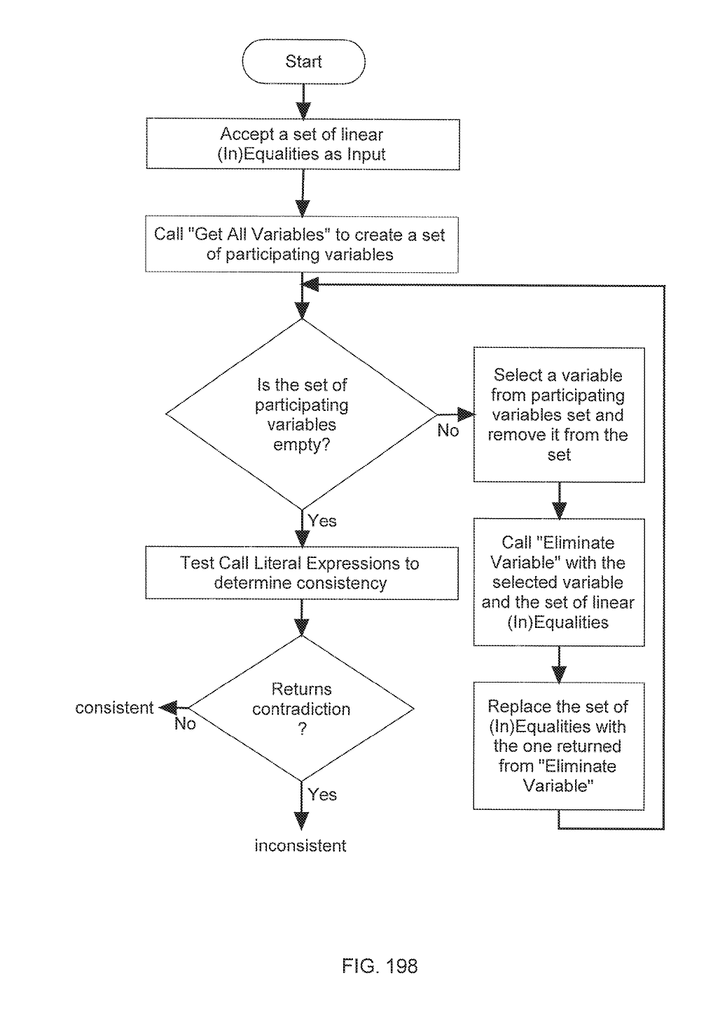

The flow chart in FIG. 198 graphically shows the logic of this process. It first invokes the subordinate process “Get All Variables” to determine which variables participate in the system or (in)equalities. A loop is used to repeatedly select/remove a participating variable, and eliminate it from the system. The resulting set is tested for contradictions using “Test Literal Expressions.” If this sub-process returns “contradiction,” then the system is inconsistent. If the sub-process returns “no-contradiction,” then it is consistent.

Consistency Example

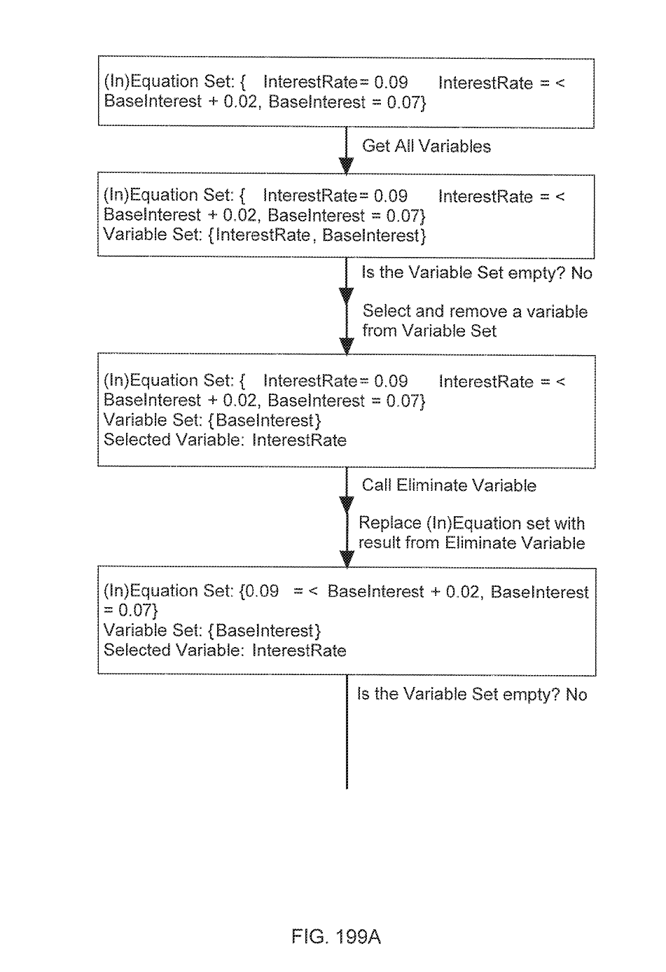

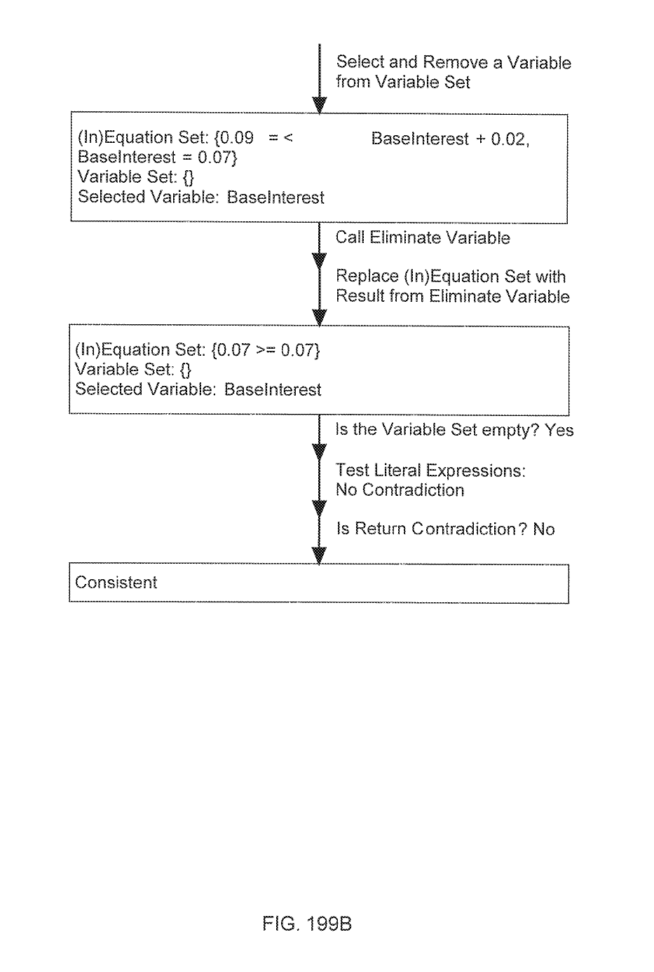

The data flow diagram in FIG. 199 shows the process in action working on a simple example. In this diagram the arcs are the process steps, and the boxes contain the changing data state. This example shows a very simple example of elimination. Intuitively, the system seems satisfiable since BaseInterest and InterestRate are set to 0.07 and 0.09 respectively, and the difference between them must be greater than or equal to 0.02. Since their difference is 0.02, there should be a feasible region. This is indeed the result given by the process: consistent.

### Inconsistency Example

Example 2

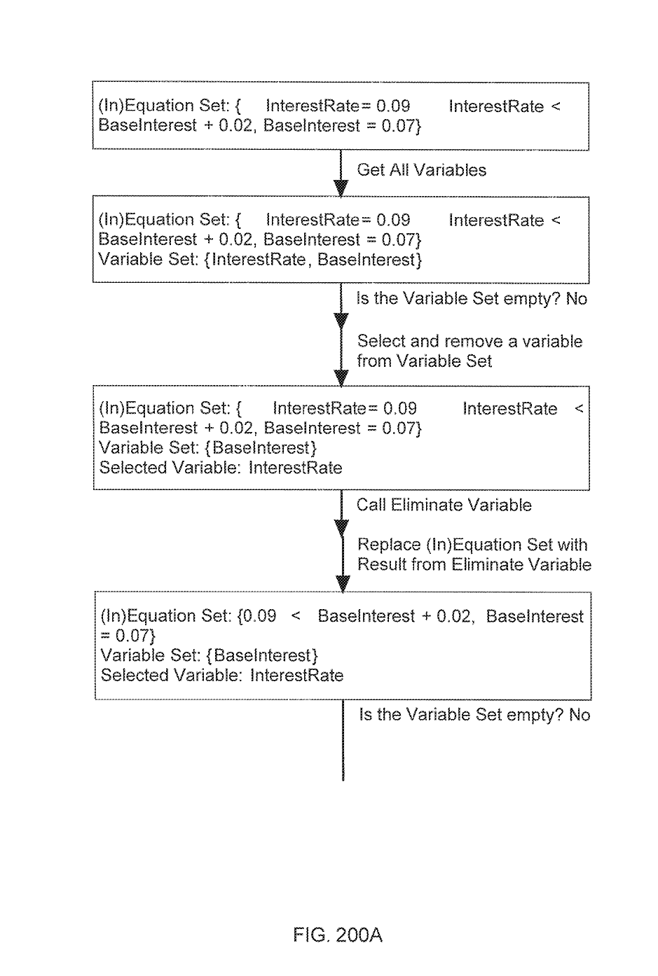

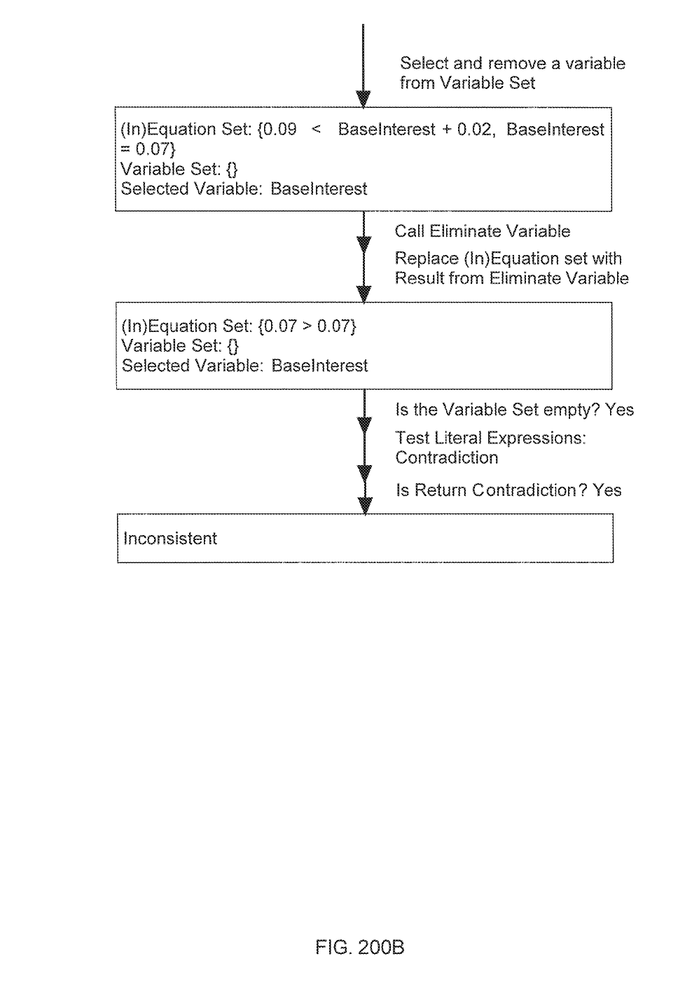

The data flow diagram FIG. 200 shows the process in action working on a simple example. In this diagram the arcs are the process steps, and the boxes contain the changing data state. This inconsistent example is almost exactly the same as the above. The significant distinction is that the difference between BaseInterest and InterestRate now must be greater than 0.02, not greater-or-equal. Since the difference is 0.02, there should be no feasible region. This is indeed the result given by the process: inconsistent.

Projection

As indicated above, the projection process returns the feasible range for any variable participating in a system of linear (in)equations. The feasible range is merely the possible valid values that the variable (or a set of variables) can take. The process is much the same as that used with consistency. The difference is that the projection variables are not eliminated, and the resulting answer is normalized in that desired variable. The input to projection is a set or system of linear equalities and inequalities, a set of variables excluded from elimination, and one variable, from the exclusion variable set, to which the resulting expressions are normalized.

Algorithm

The flowchart in FIG. 201 outlines the projection process.

Example

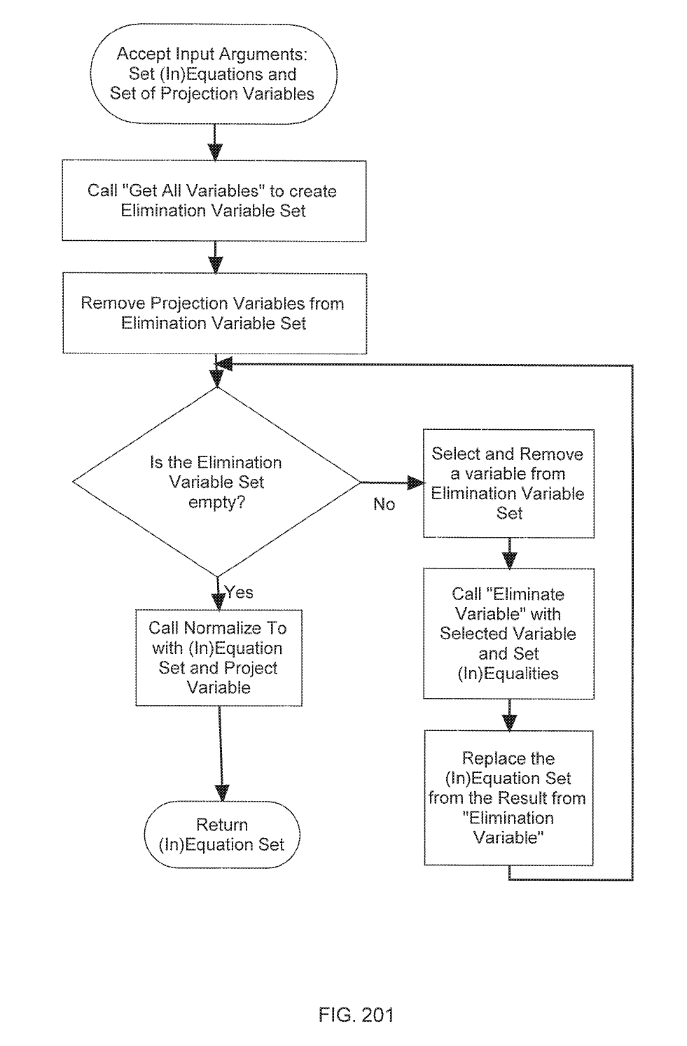

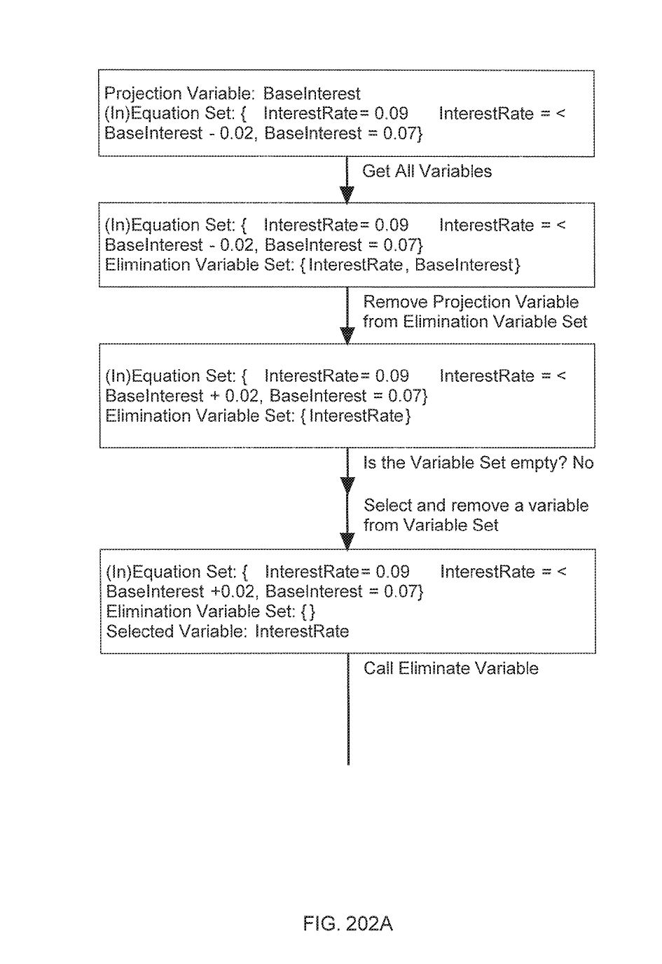

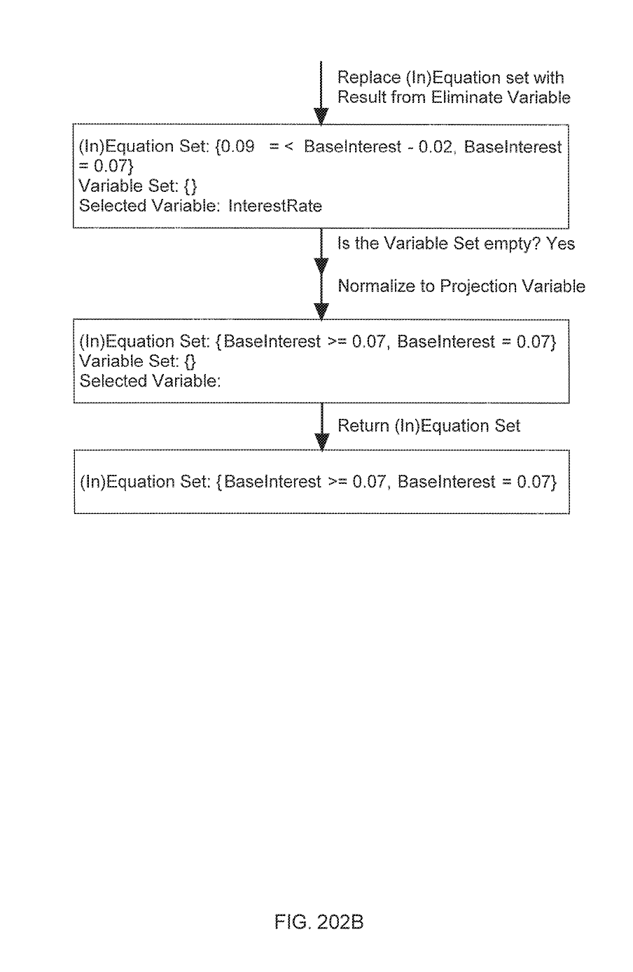

The data flow diagram in FIG. 202 shows the process in action working on a simple example. In this diagram the arcs are the process steps, and the boxes contain the changing data state. The example follows the same system of inequalities used in the consistent example in the previous section. The projection results with: BaseInterest >=0.07, and BaseInterest=0.07

Shared Processes

### Eliminate Variable

“Eliminate” eliminates the input variable from the system of (in)equations, and produces a new system of (in)equalities, which is returned to the calling process.

Algorithm

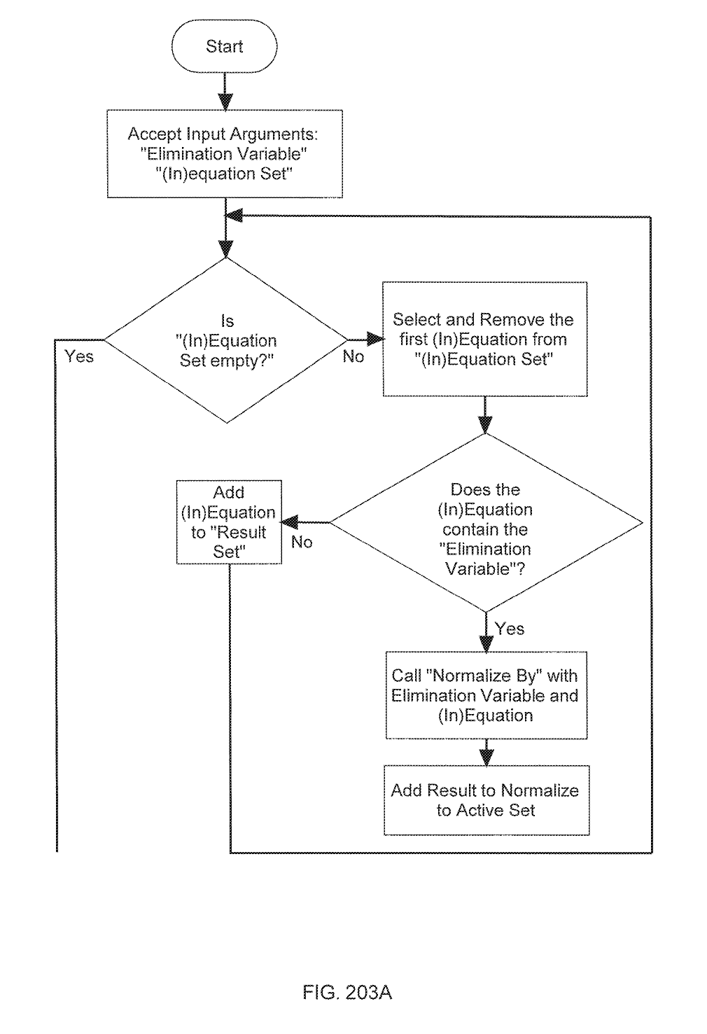

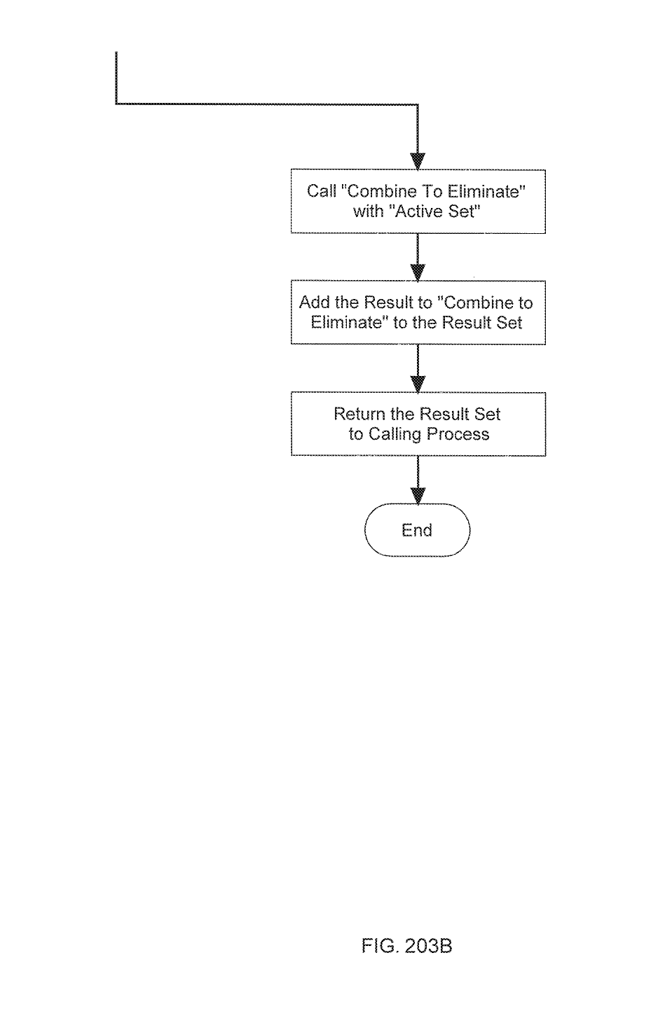

The flowchart in FIGS. 203A-203B illustrates this process. This process accepts two input arguments, the “active” variable, and a system, or set, of (in)equations. The process then loops through the input set of (in)equations sorting them into two sets. The active sets are those that will participate in this round of elimination, because they refer to the “active” variable. Those that are inactive, that do not refer to the active variable, are added to the “result set” untouched. The active (in)equations are normalized by calling the process “Normalize By.” The process then takes the normalized “active set” and calls the “Combine to Eliminate” process, which produces a new set of (in)equalities in which the “active” variable has been eliminated. The members of this set are added to the result set. The result set is returned to the calling process.

Example

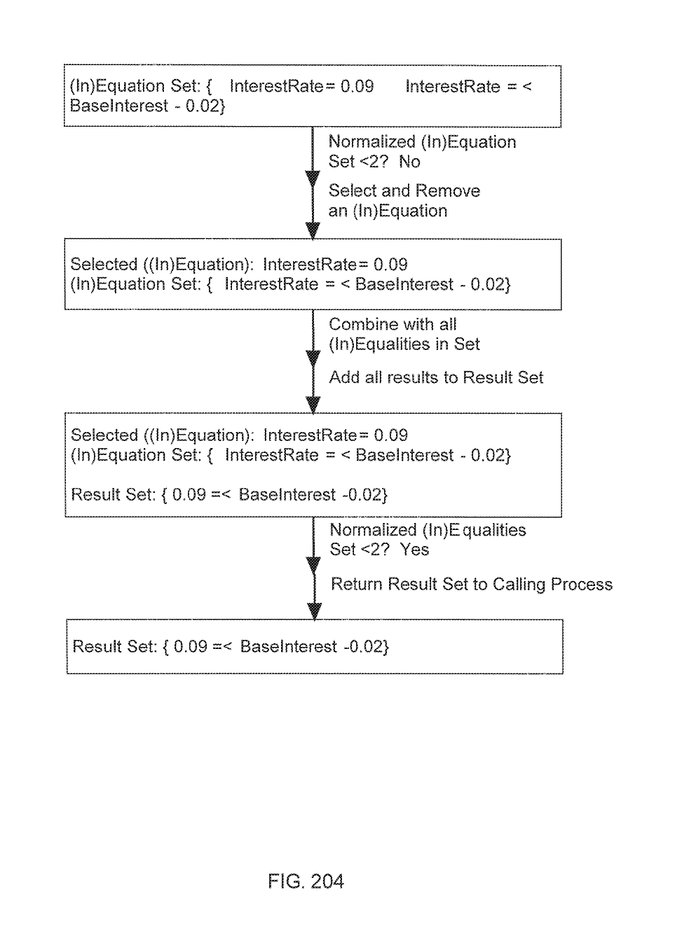

The data flow diagram in FIG. 204 shows the process in action working on a simple example. In this diagram the arcs are the process steps, and the boxes contain the changing data state.

CombineToEliminate

The “Combine to Eliminate” process takes a set of normalized (in)equalities, and combines them to produce a new set, having eliminated the “elimination variable.” Again, this process uses the well-known elimination principles taught on the high-school level throughout the world.

Algorithm

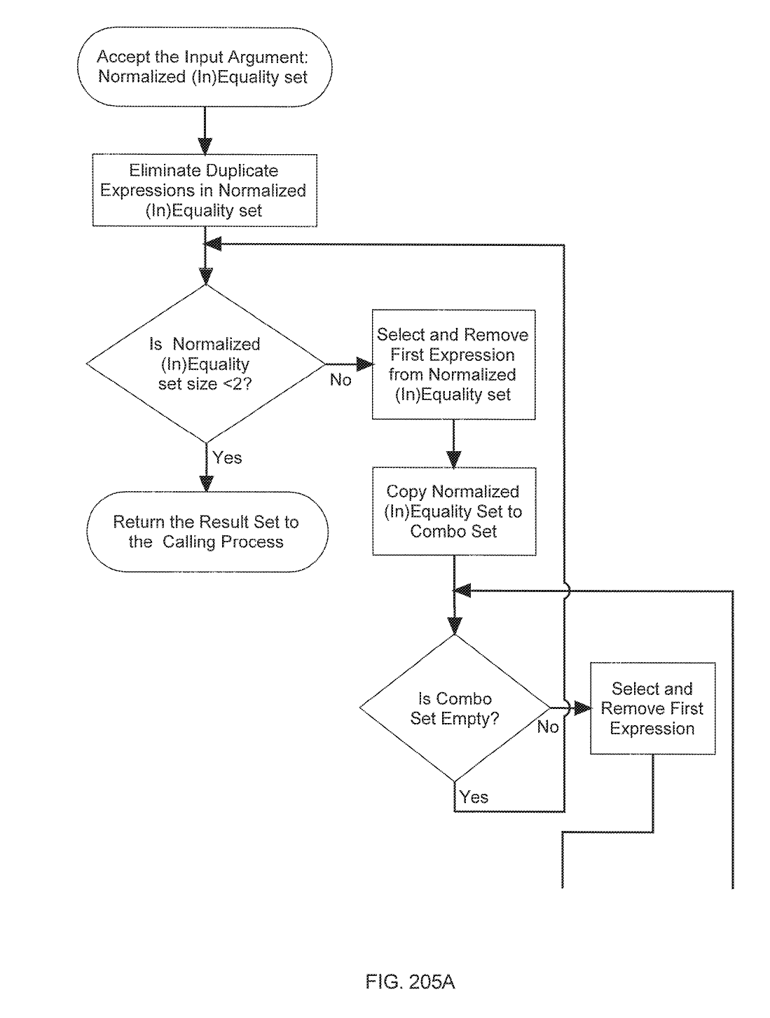

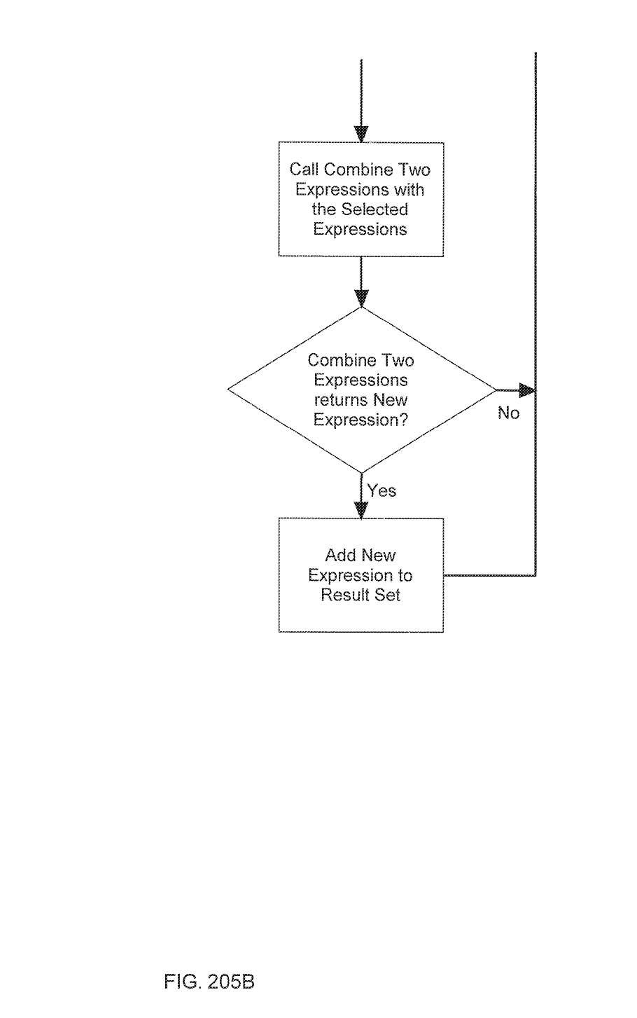

The flowchart in FIGS. 205A-205B illustrates this process. The process accepts a set of (in)equalities previously normalized by the “Normalize By” process. The algorithm then proceeds to produce all possible combinations of new (in)equalities, replacing the “elimination variable” on the left side of each (in)equality with all other right sides in the set. This is done by repeatedly invoking the “Combine Two Expressions” process. Each of these new (in)equalities is added to the result set. The result set is then returned to the calling process.

Example

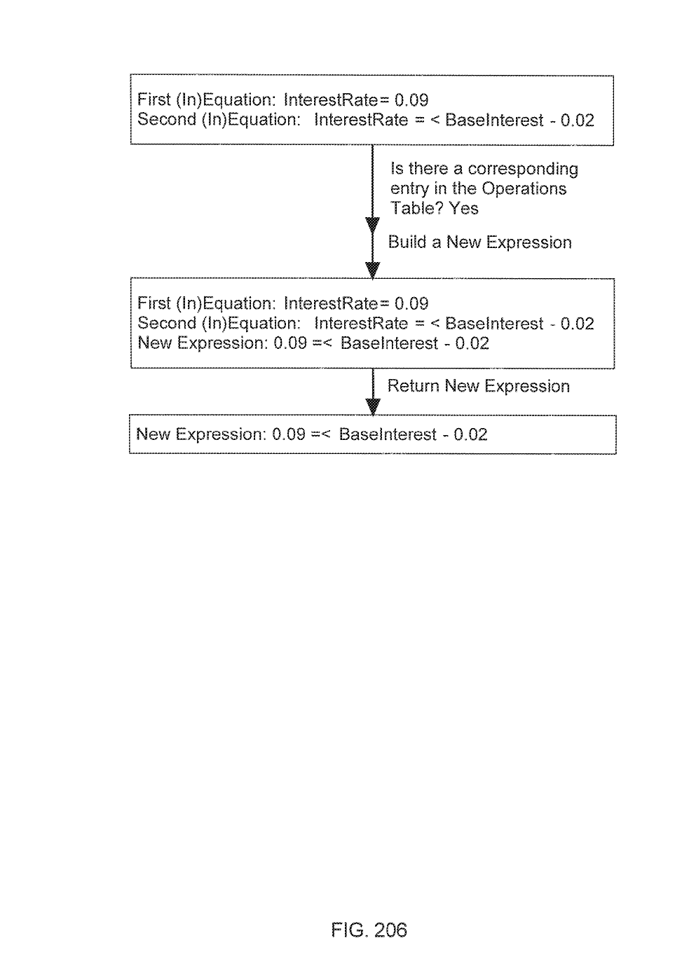

The data flow diagram in FIG. 206 shows the process in action, working on a simple example. In this diagram the arcs are the process steps, and the boxes contain the changing data state.

CombineTwoExpressions

The “Combine Two Expressions” process takes two expressions that are in the same normal form (see Normalize By), and determines whether the two (in)equations result in a constraint on the projection (feasible region) of the remaining variables. If the two input (in)equations will constrain the projection on the remaining variables, then a new (in)equation is built and returned. If the two (in)equations do not constraint the remaining variables, then no expression is returned.

Algorithm

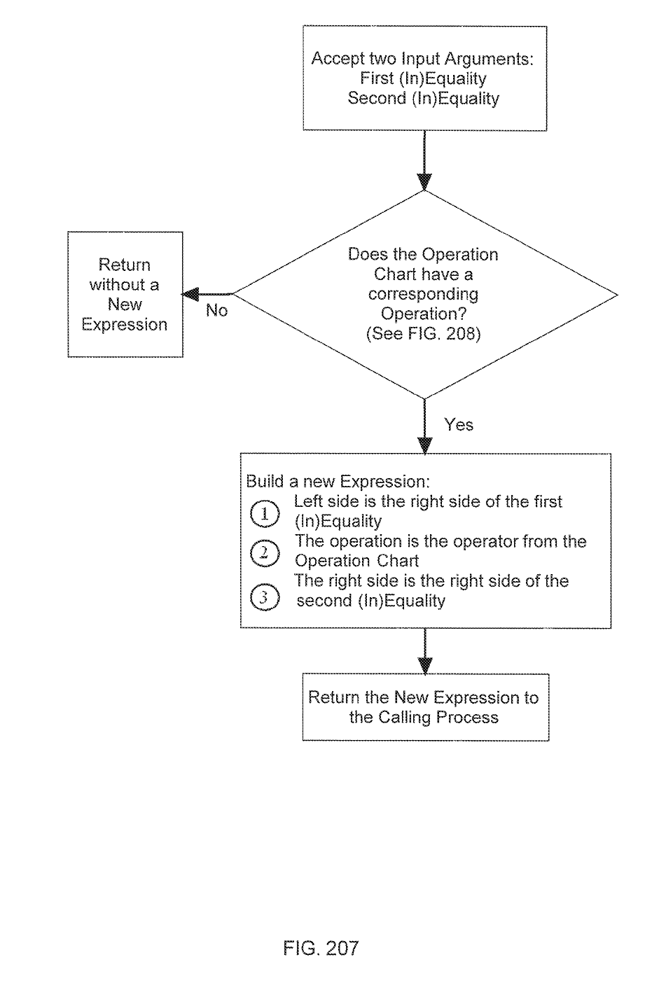

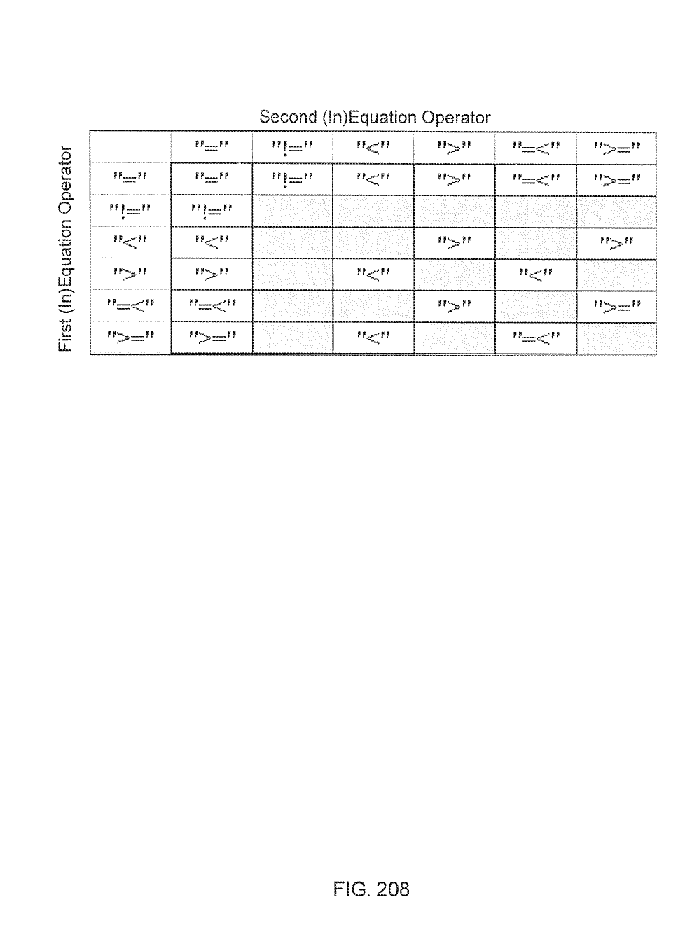

The flowchart in FIG. 207 illustrates this process. The core of this process is the Operation Chart shown in FIG. 208. In essence, the process is entirely determined by the chart. If the operators from the two input (in)equalities converge on an empty cell, nothing is returned. If, however, the operators converge on a cell that contains an operator, then a new expression is built and returned.

As to the origin of the chart, the correctness and completeness of this approach has been in the public domain for approximately two hundred years (Joseph Fourier lived from 1768 to 1830); and it is commonly used on an undergraduate level in teaching the concepts of Constraint Programming.

Example

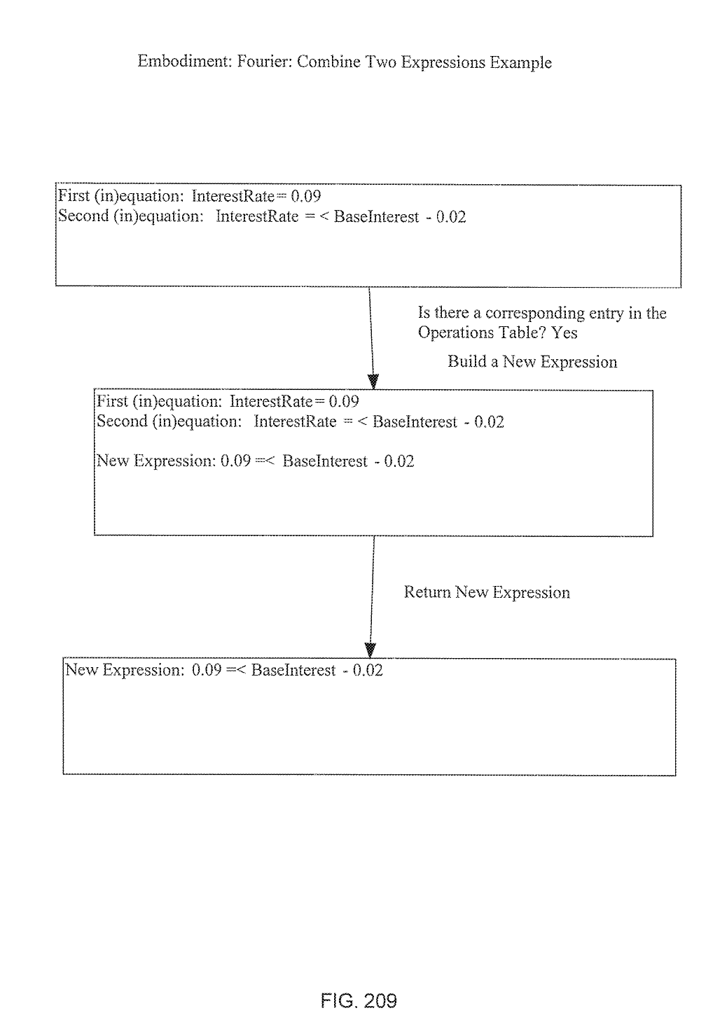

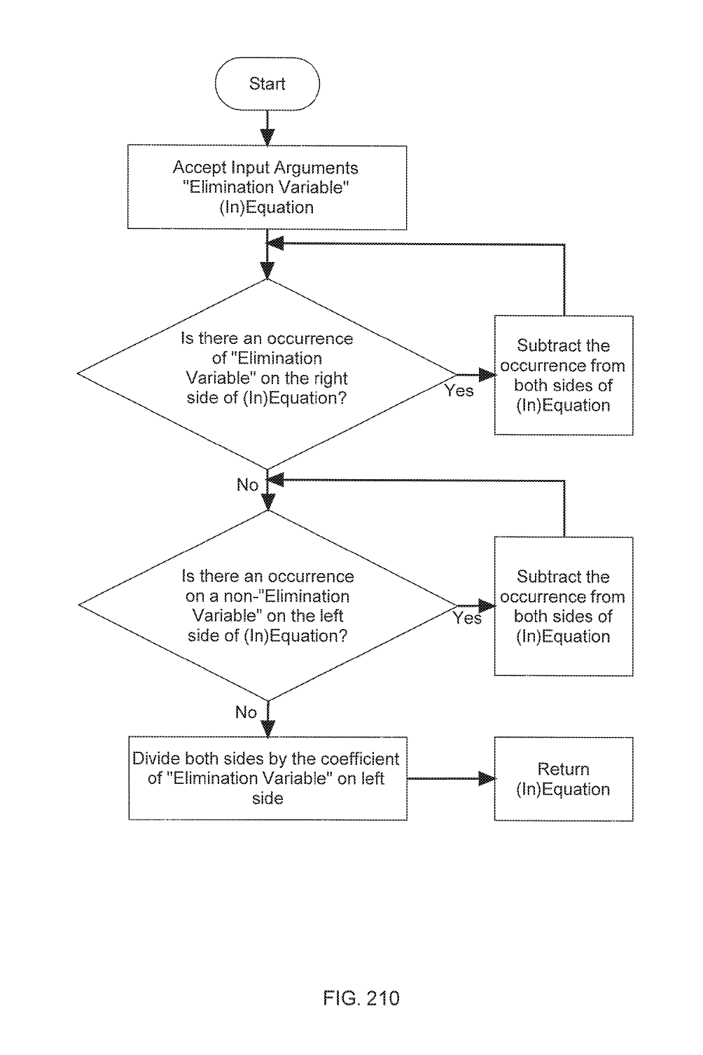

The data flow diagram in FIG. 209 shows the process in action, working on a simple example. In this diagram the arcs are the process steps, and the boxes contain the changing data state.

NormalizeBy

The “NormalizeBy” process takes an “elimination variable” and an (in)equation as input and returns an equivalent (in)equation in “left-normal form.” This simply means that that normal occurrence of the “elimination-variable” (i.e. multiplied by a coefficient of 1) occurs on the left side, and exclusively all other variable and constraint references are on the right side. The process is the familiar one from high-school mathematics, subtracting expressions, in this case, coefficient*variable, from both sides of the (in)equation.

Algorithm

The flowchart in FIG. 201 illustrates this process. The process accepts two arguments, the elimination variable and the (in)equation that will be normalized. All expressions on the right-side of the (in)equation that reference the elimination variable are subtracted from both sides. That is, if coefficient*elim-variable occurs on the right, subtract coefficient*elim-variable from both sides. All expressions on the left side that contain a variable that is not the elimination variable, are subtracted from both sides. Both sides are then divided by the coefficient of the elimination variable. This results in the left-side always having a unit (1) coefficient. Note, that if the coefficient is negative, and the operator is a relational inequality, the direction of the inequality is inverted. This is illustrated in the example below. The resulting equivalent (in)equality is returned to the calling process.

Example

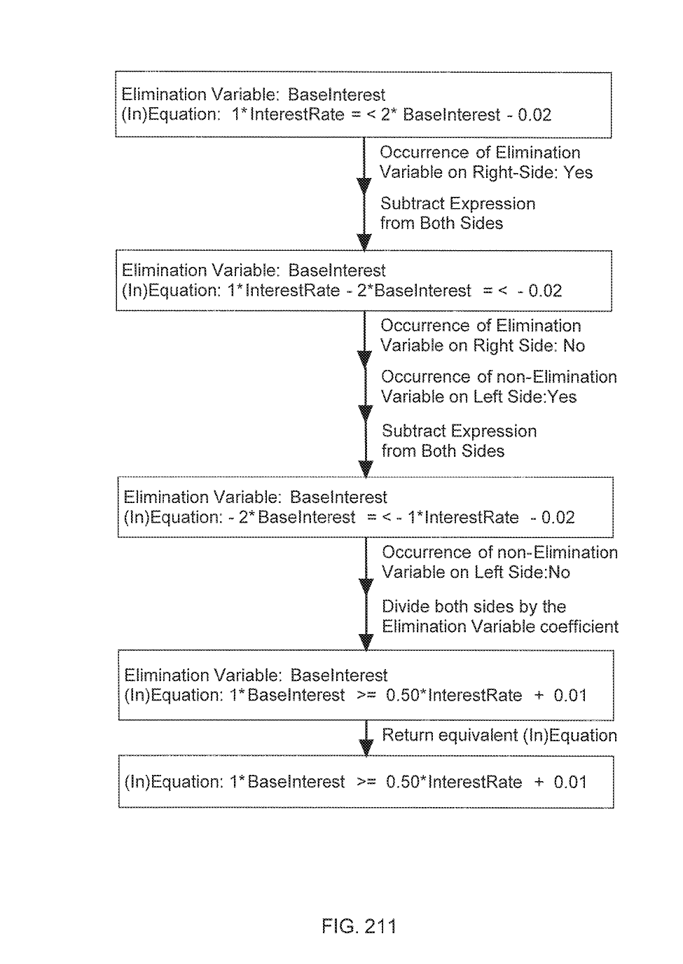

The data flow diagram in FIG. 211 shows the process in action, working on a simple example. In this diagram, the arcs are the process steps, and the boxes contain the changing data state.

TestLiteralExpressions

Test Literal Expressions accepts a set of literal (in)equalities and tests to see if any of the literal expressions are invalid expressions. Typically the elimination process reduces the system to a set of literal expressions. If there is a feasible region in the original system of (in)equalities, then the resulting literal expressions will all be valid. If there is no feasible region, then a contradiction (an invalid literal expression) must exist.

Algorithm

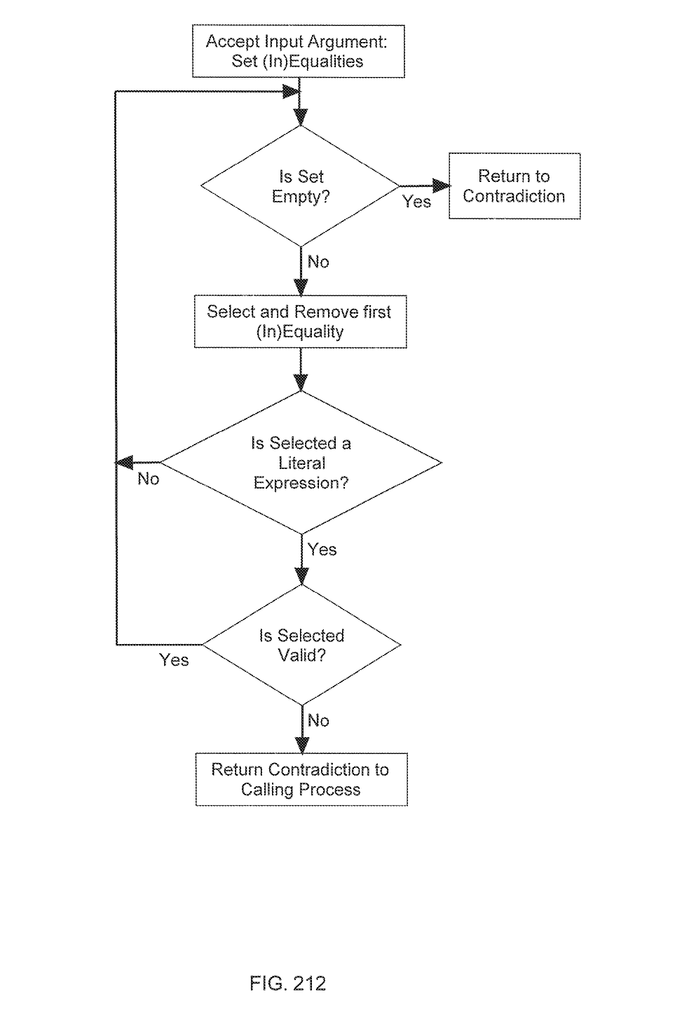

The flowchart in FIG. 212 illustrates this process. The process merely loops through the set of (in)equalities looking for an invalid expression. If one is found, then “contradiction” is returned. If no contradictions are found, the “no contradiction” is returned.

Example

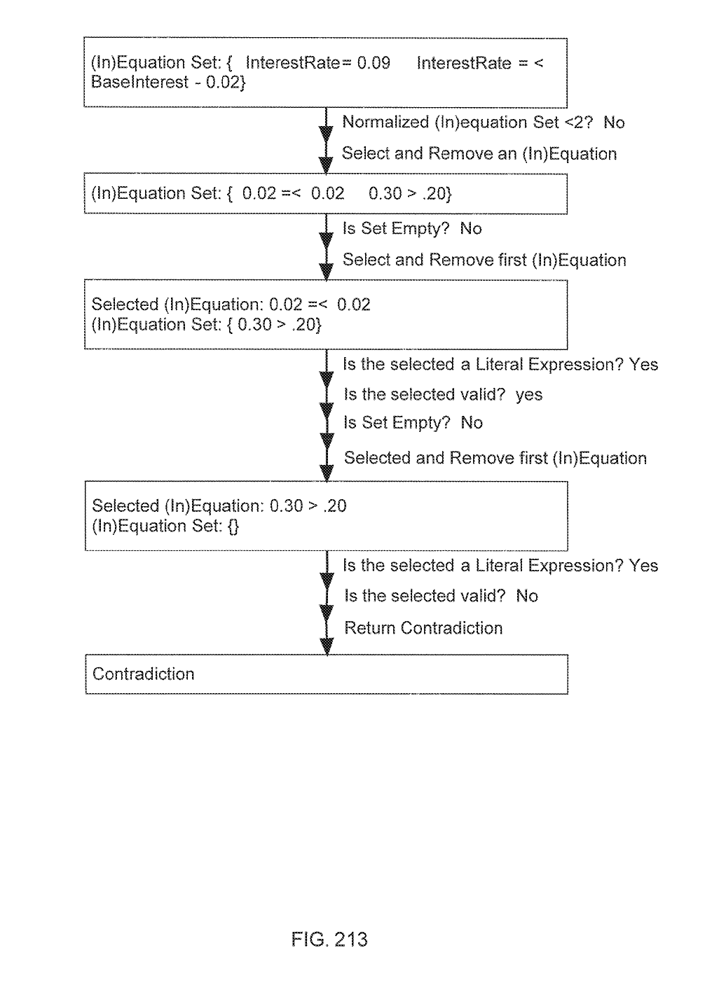

The data flow diagram in FIG. 213 shows the process in action working on a simple example. In this diagram, the arcs are the process steps, and the boxes contain the changing data state.

Get all Variables

The “Get all Variables” process merely returns a set of all variable occurrences in the system (set) of (in)equalities. This set then is used in the elimination process.

Algorithm

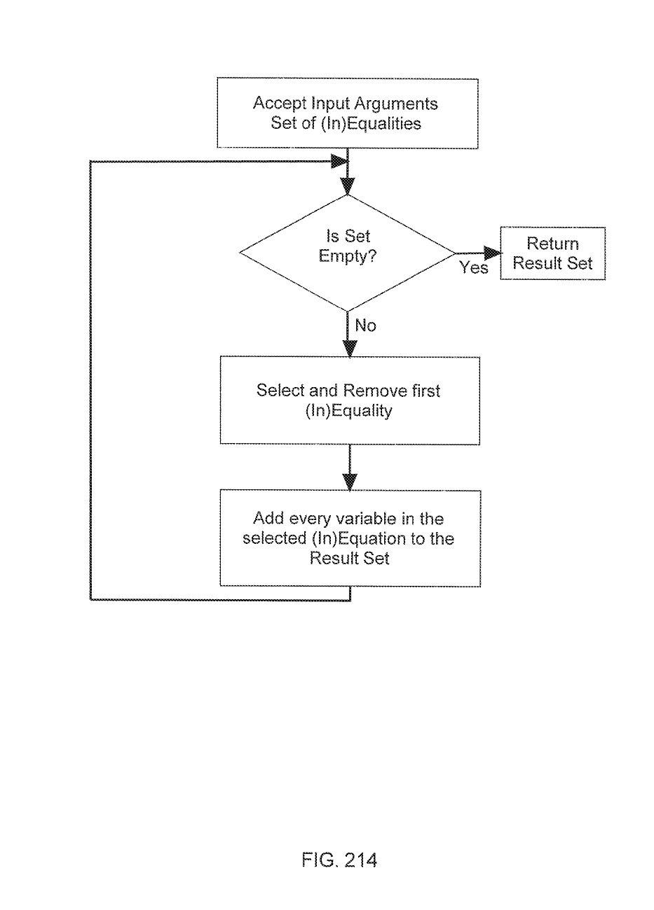

The flowchart in FIG. 214 illustrates this process. It merely loops through the set of (in)equalities, collecting a set of variables

Example

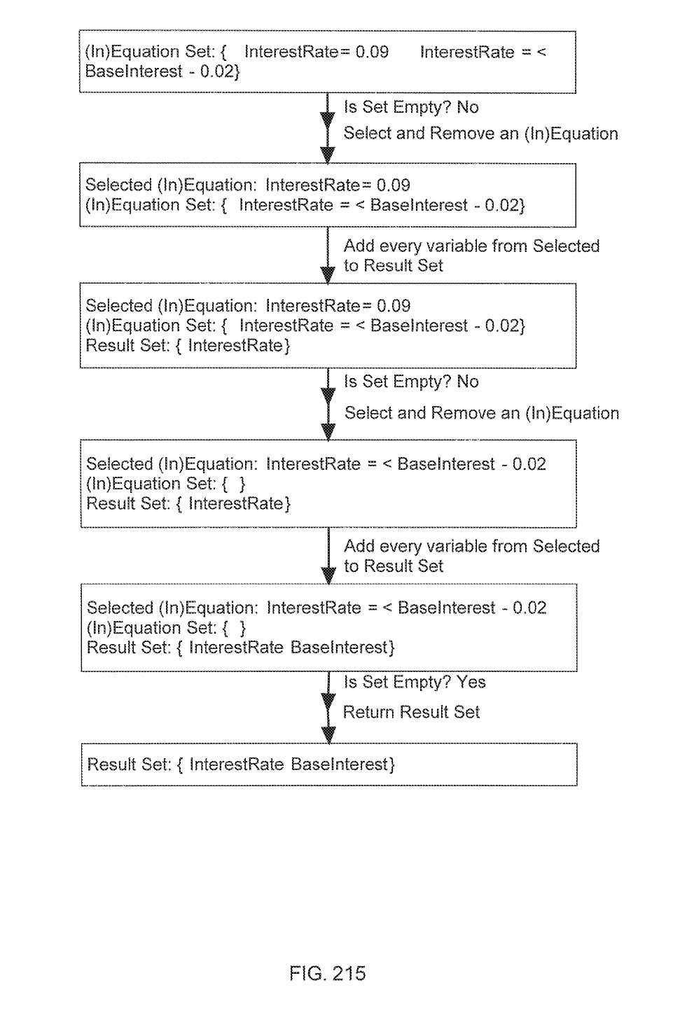

The data flow diagram in FIG. 215 shows the process in action, working on a simple example. In this diagram the arcs are the process steps, and the boxes contain the changing data state.

Format Model

The format model process accepts the path-data model set as input, and returns a Finite Input Output Semantic Model (FIOSM) as output. This completes the process for generating a FIOSM.

The path-data model is identical to the Valid-Model set contained in the Model Generator. This was discussed above in the Tableau section. The FIOSM format was defined above in the FIOSM Definition section of this example. The process itself is conceptually quite simple. The Model Containers in the Valid-Model set contain all the information for a FIOSM; it is merely a matter of extracting it and formatting it.

As repeatedly mentioned above and in this example, identifying what constitutes input and output is a critical decision. For this Embodiment, a programmer's perspective is taken. This choice is realized in the processes “Find Input Elements” and “Find Output Elements.”

Format Model Processes

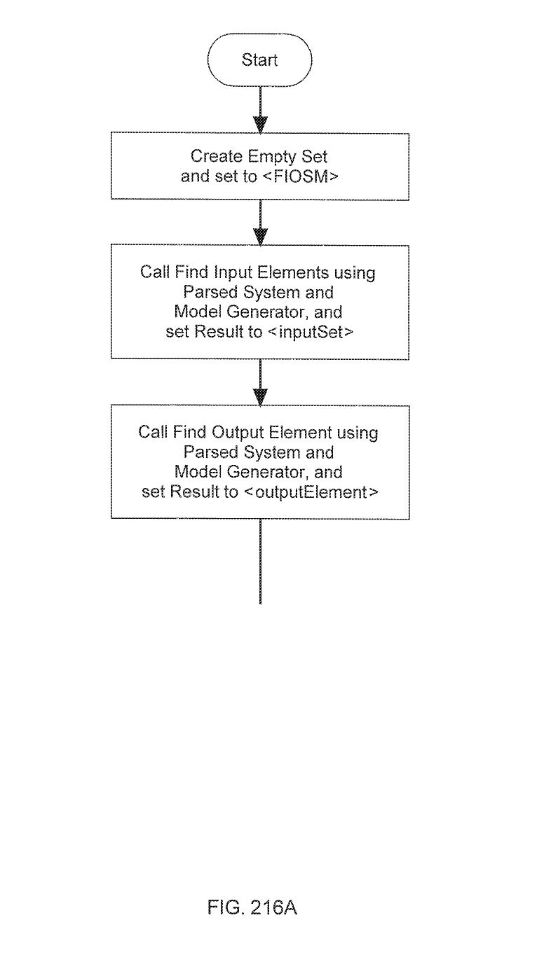

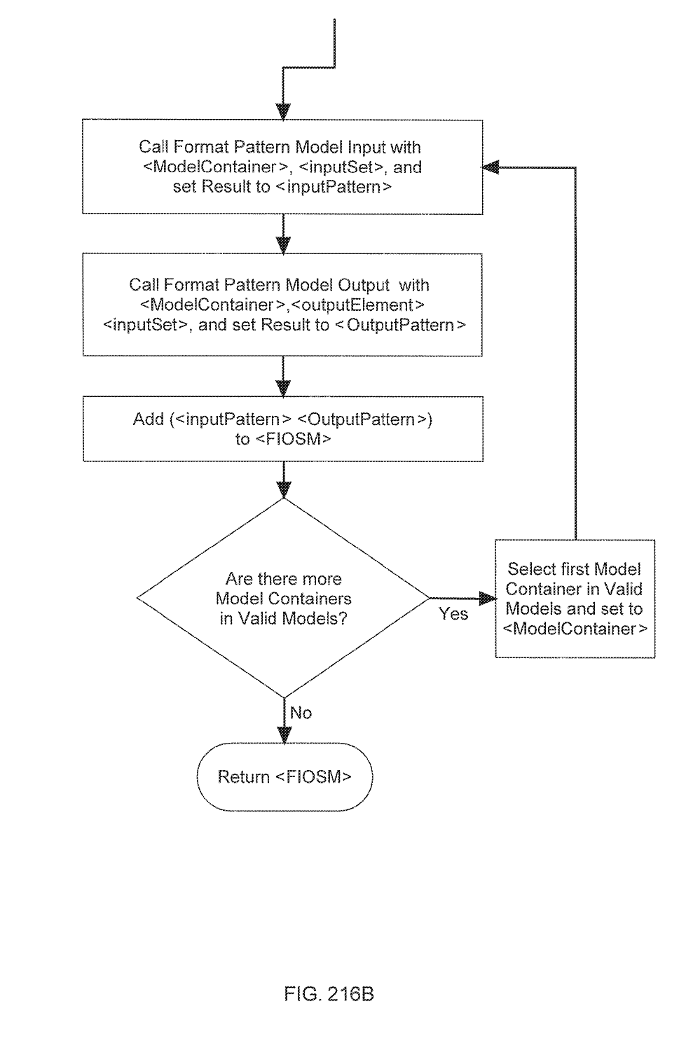

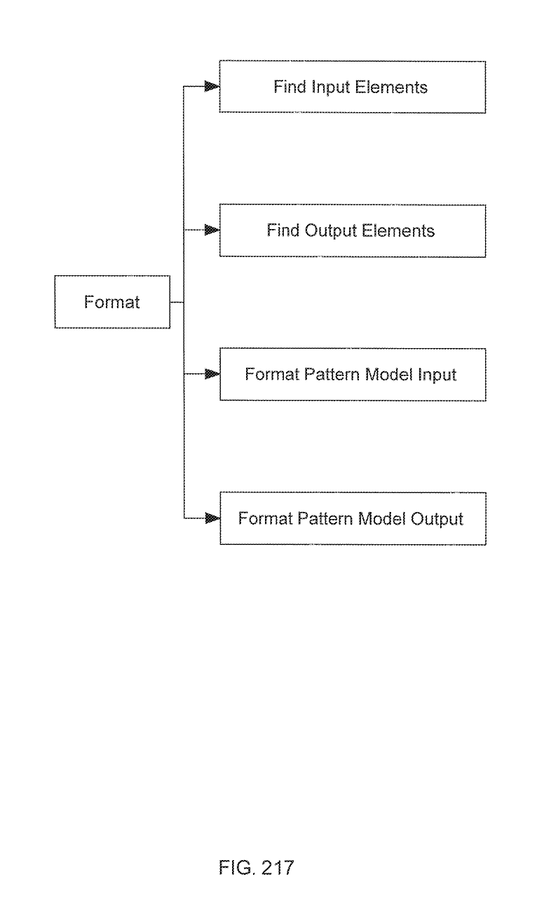

The main process for translation is the process Format Model (FIG. 216), which accepts a Model Generator as input and returns the FIOSM as output. Format Model calls subordinate processes, which comprise the totality of its function. A brief description of the subordinate processes is summarized below. The higher-level relationship of processes to one another is illustrated in FIG. 217.

Format Model (FIG. 216) accepts a Model Generator and returns the corresponding FIOSM.

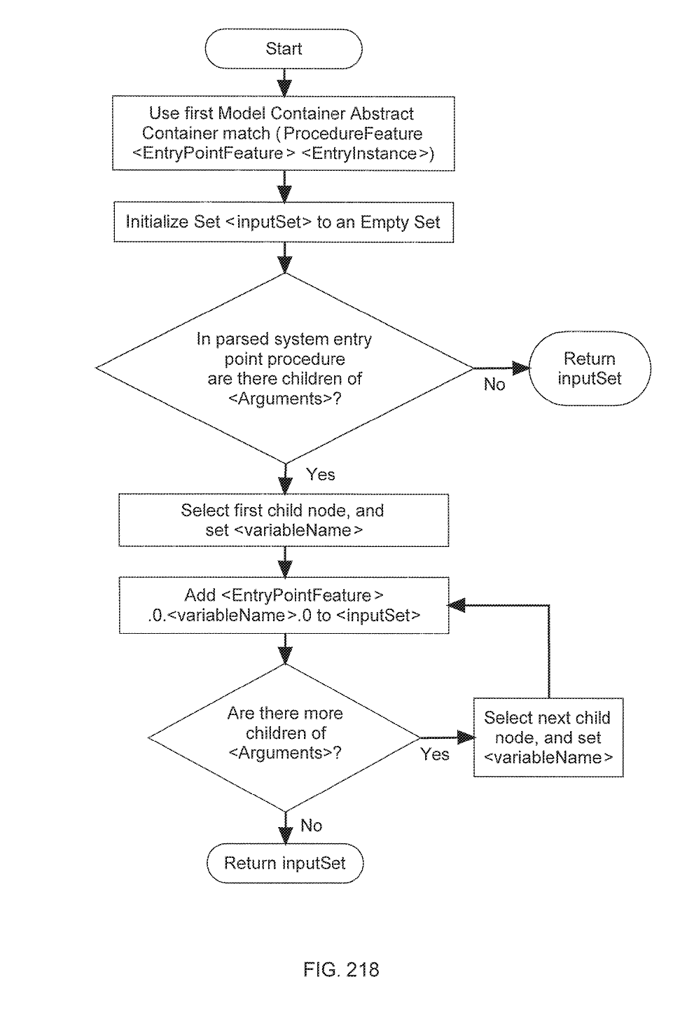

Find Input Elements (FIG. 218) determines the names of the input data elements to the system by analyzing the arguments of the system's entry point procedure.

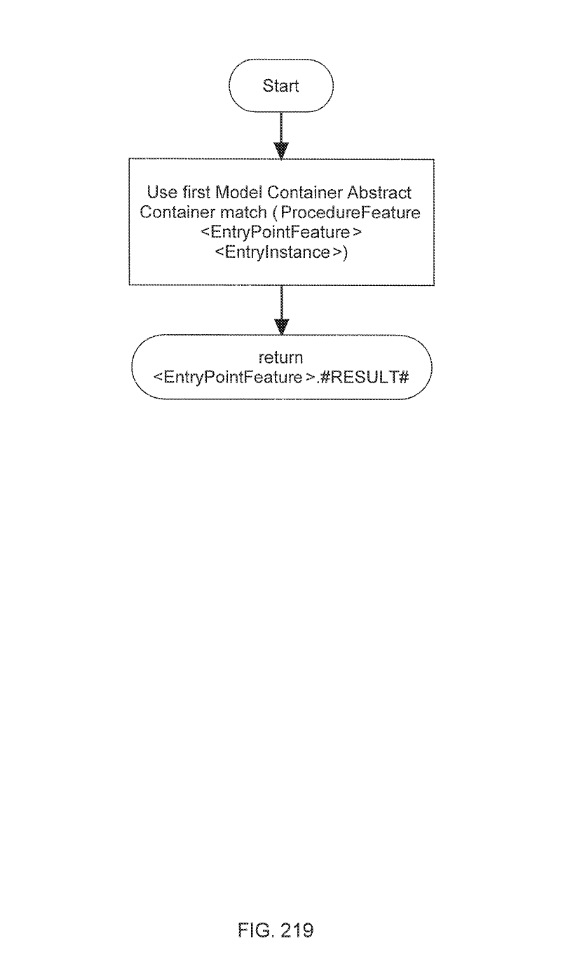

Find Output Element (FIG. 219) determines the name of the return data element of the system by analyzing the system's entry point procedure.

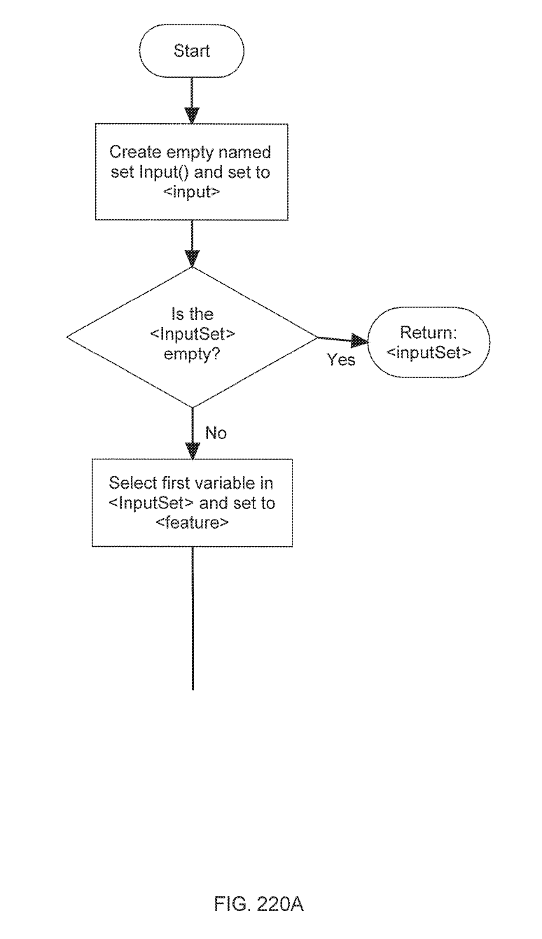

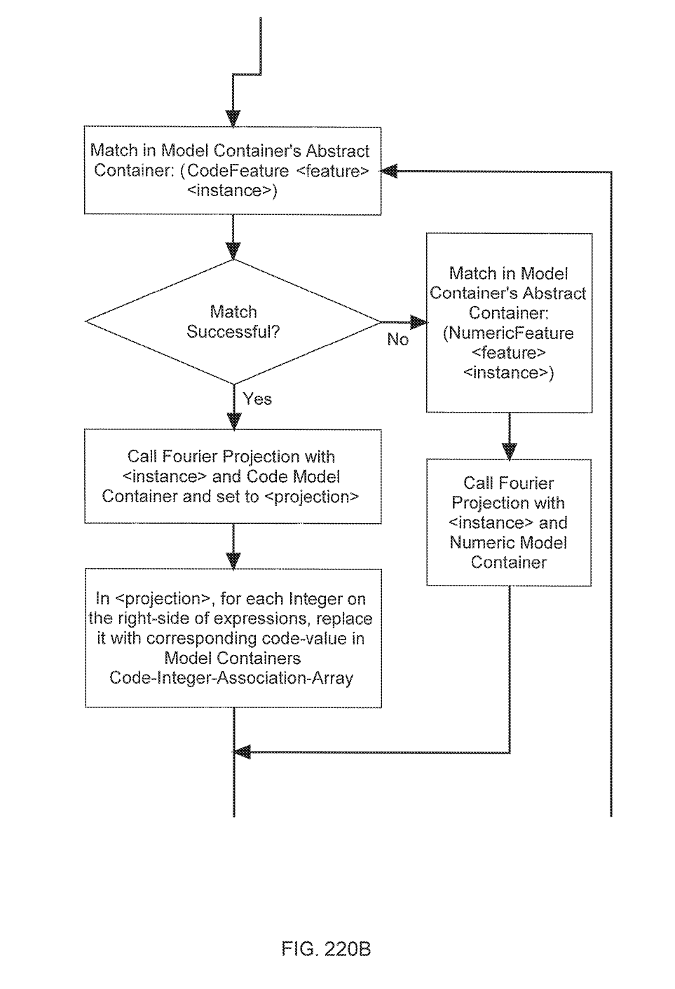

Pattern Model Input (FIGS. 220A-220C) use the identified input data elements, to extract the input portion of the pattern model, and format it to the FIOSM form.

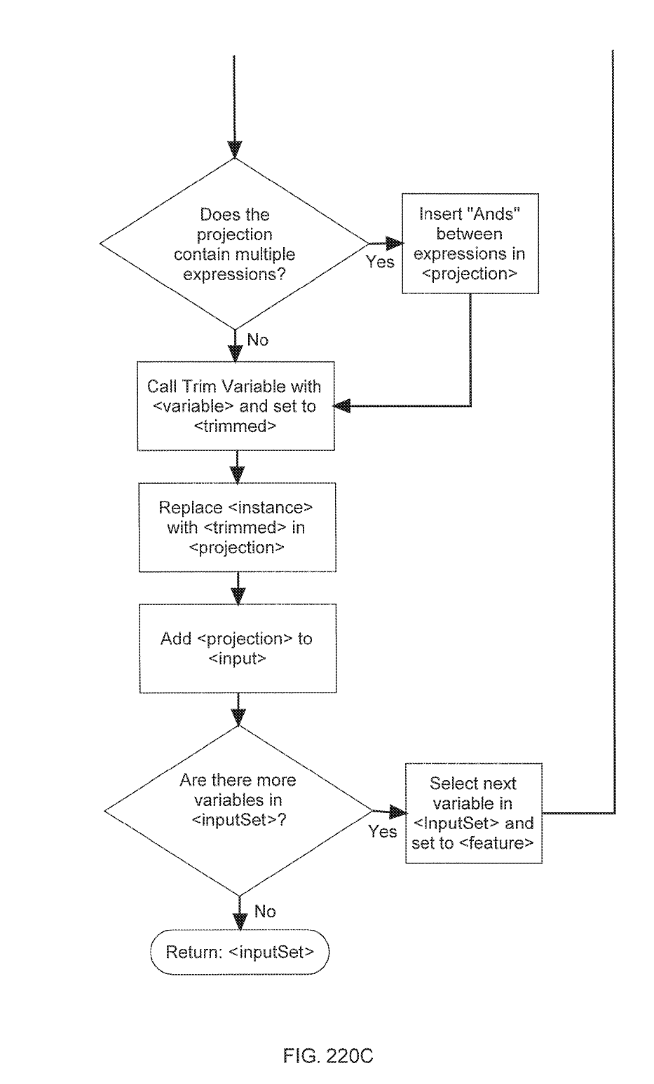

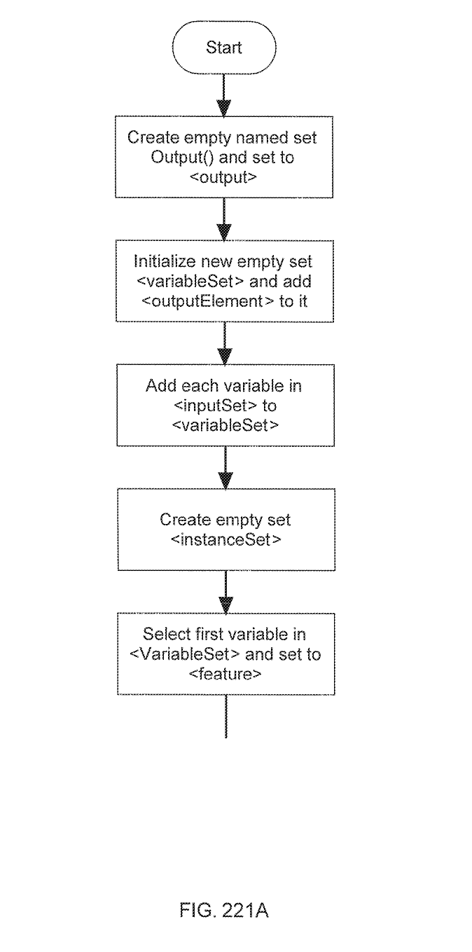

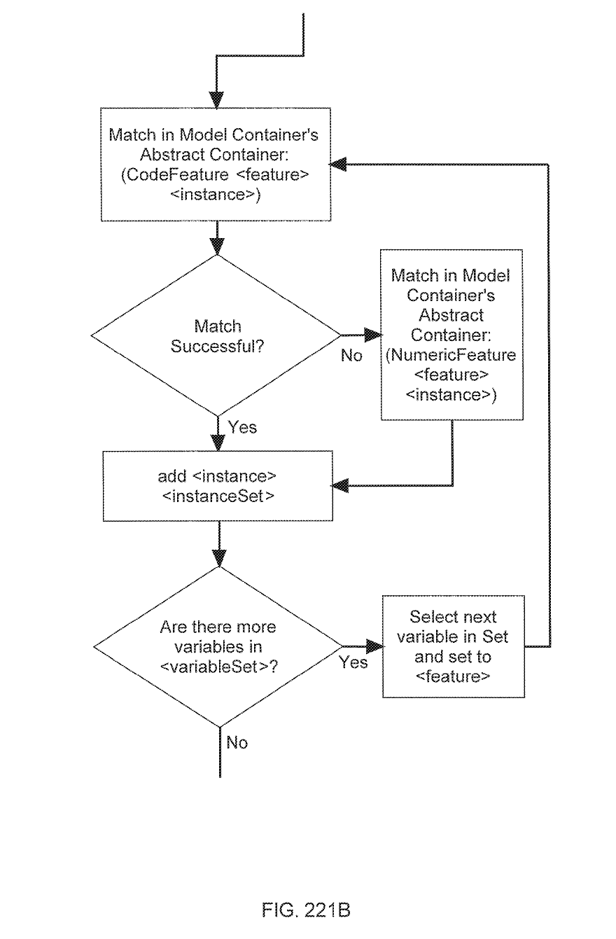

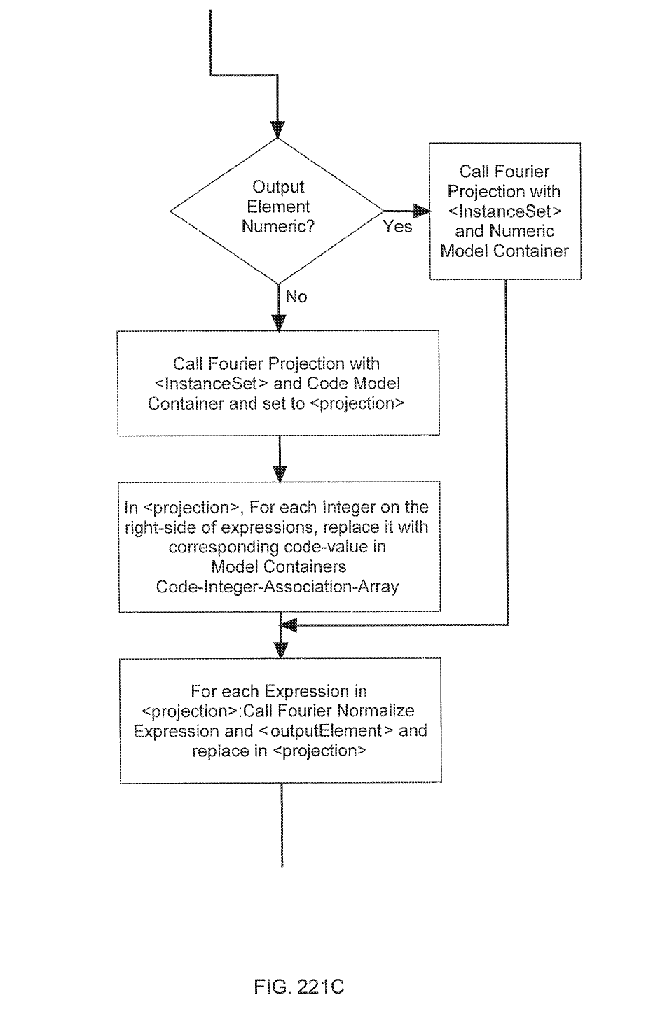

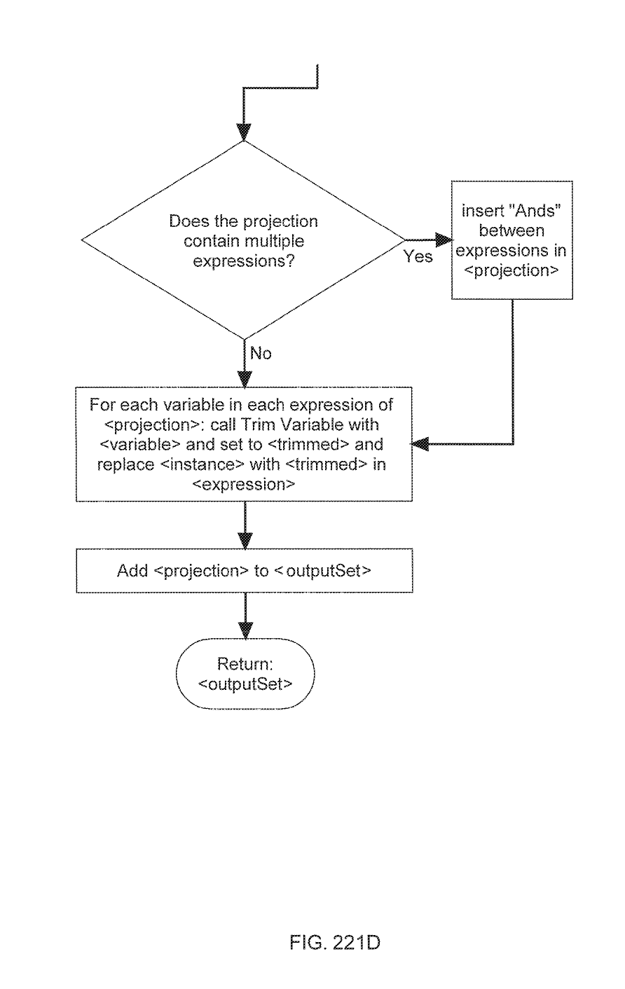

Pattern Model Output (FIGS. 221A-221D) use the identified output data element to extract the output portion of the pattern model, and format it to the FIOSM form.

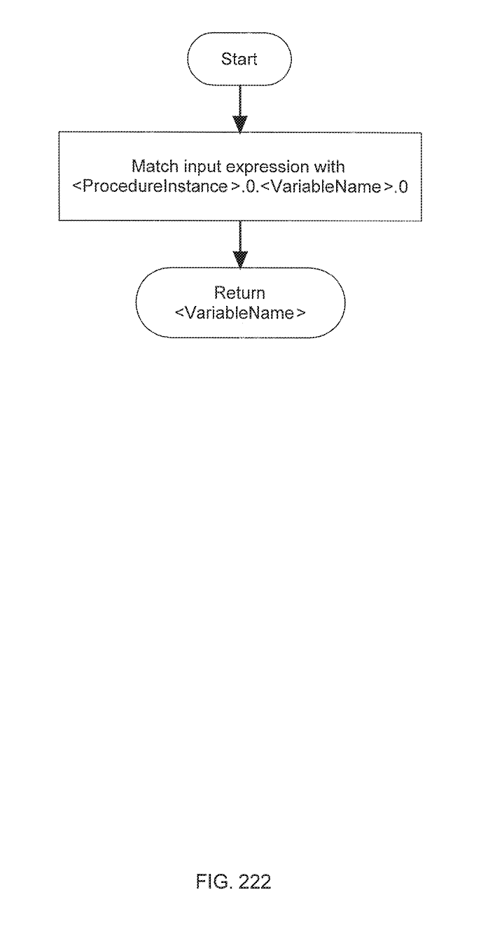

Trim Variable (FIG. 222) accepts a variable name in the form used by the model container, and converts it to the form required by the FIOSM, as defined in the FIOSM definition section above.

Example

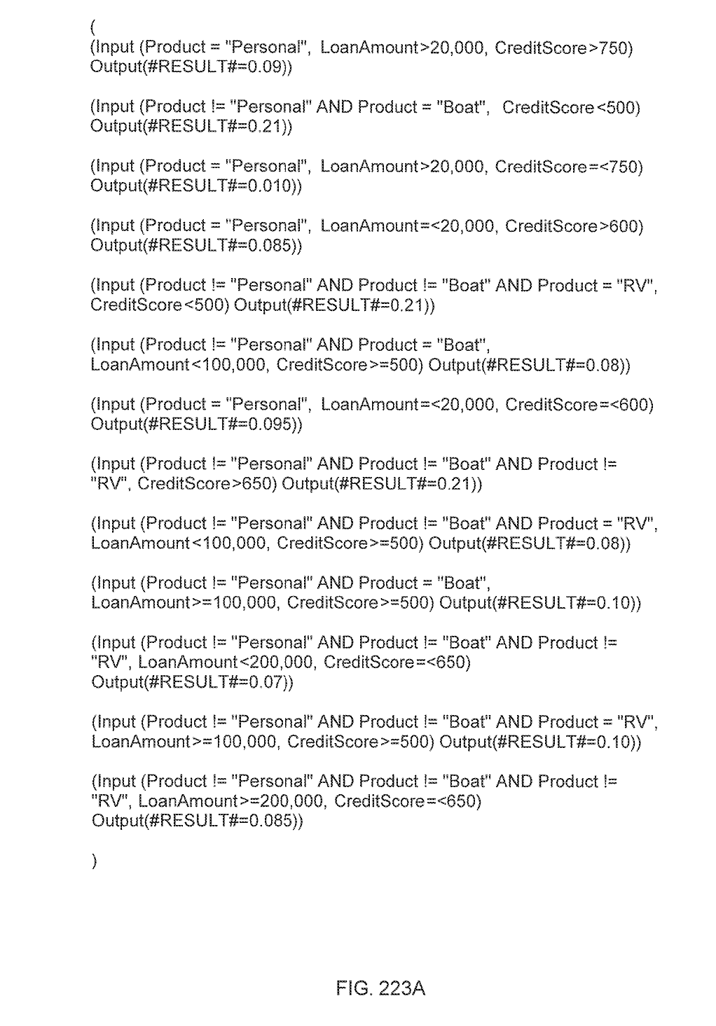

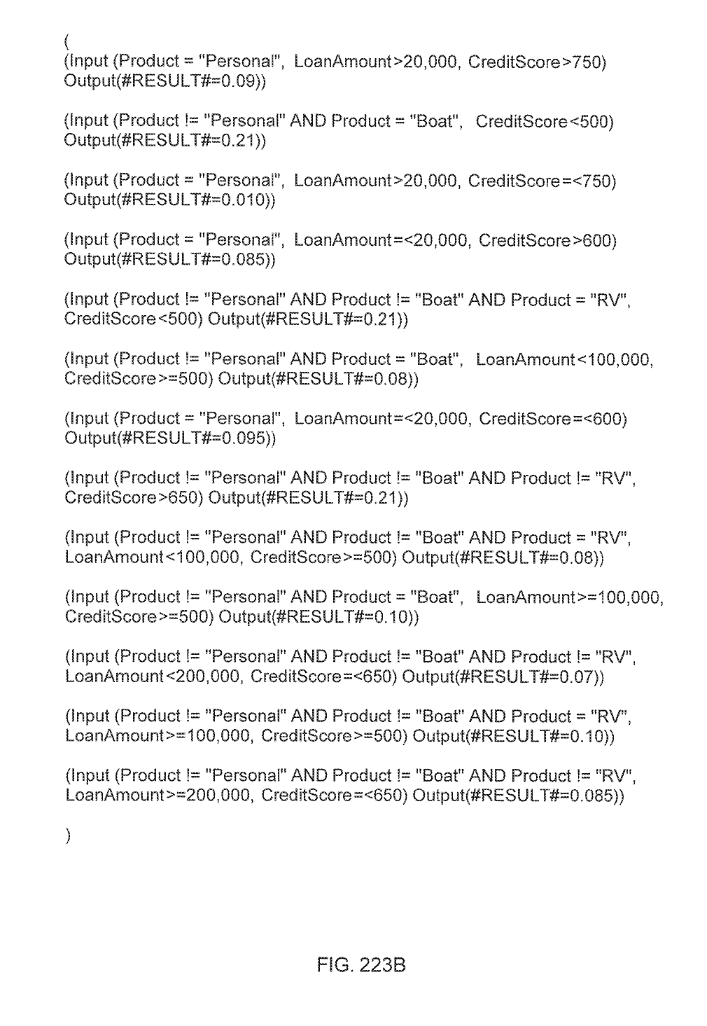

Using as input the Model Generator result produced by the Generate Path-Data Model above (diagram Model Generator MG 5) and the contained Model Containers, the Format Model process produces a Finite Input Output Semantic Model (FIOSM) in FIG. 223. The formatting process is straightforward and does not require a detailed step-by-step analysis.

Comparison/Subsumption

The exemplary embodiments of the ioSemantics tools, systems and methods provide not only the ability to generate a Semantic Model for software programs, routines, procedures and the like, but also provide for comparison techniques applied to Semantic Models that result in enhanced reasoning capabilities for users thereof and permit automation of software development processes that to date have been practically impossible to automate.

The generation of a Finite Input/Output Semantic Model (FIOSM or Semantic Model) is useful in its own right because, for example, it can state definitively and finitely the behavior of a program, which can, for example, be used by quality control personnel to verify proper operation of a new piece of software.

Beyond the inherent usefulness of being able to generate a Semantic Model for any software program, routine and/or procedure written in a compatible language, there is also additional usefulness in being able to apply reasoning operations to the Semantic Model. Embodiments of the reasoning operations are based on the ability to determine a subset relationship between inputs and outputs of two different programs. The ability to determine subset relationships between sets is referred to as a “Subsumption Operation” in mathematical logic and ontology (reference: Handbook of Description Logic). In the context of software comparison, the process is simply referred to as “Comparison.”

The exemplary embodiments of the ioSemantic tools, systems and methods, are discussed in relation to three levels.

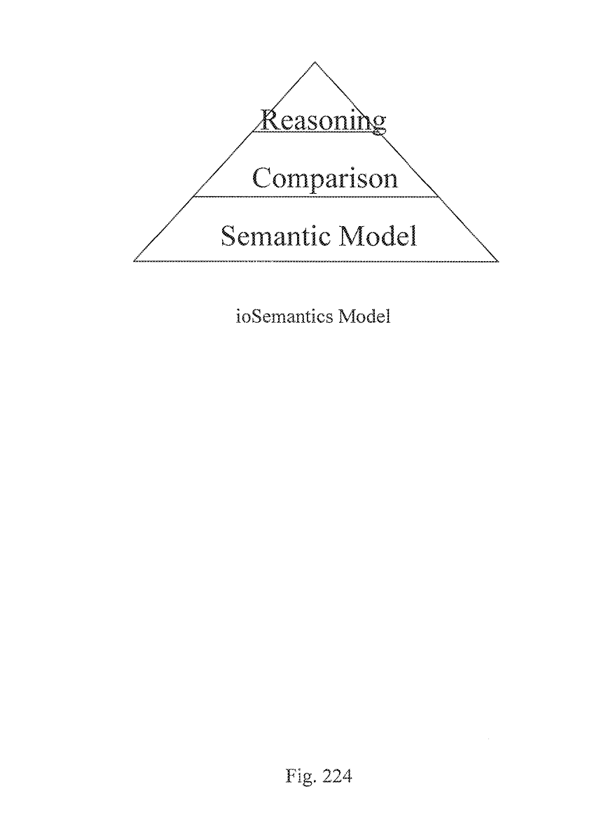

One approach used to move “analyzable” systems into the realm of pragmatic use can be represented as a pyramid and is depicted in FIG. 224.

As the pyramid indicates, one core ability or foundation of the ioSemantics tools, system and method is the generation a Semantic Model, which changes a given program into a data type that can then be compared to other instances of Semantic Models (also referred herein as an “FIOSM”). The use of Semantic Models (FIOSM) makes it possible to extract meaning that is amenable to automated computer processes. The success of the processes depicted on the other two levels of the pyramid is based on the ability of the system to do this extraction, thus, to make subject software machine analyzable.

The second level of the pyramid is Comparison, which is done utilizing the Semantic Models of two programs, with the method in at least one embodiment being the set-theoretic approach described herein.

At the third level is Reasoning. Reasoning Services are methods that target the software engineering activities, such as Quality Assurance (discussed hereinafter). These methods require well-defined and well-behaved data and data operations to work; the FIOSM and Comparison serve these roles correspondingly.

Comparison is the fundamental operation on the Semantic Model (FIOSM) that makes all Reasoning Services possible. The discussion here focuses on embodiments pertaining to this second level of the pyramid and provides an example of the practical value of Comparison and Reasoning Services, and a brief example of implementation.

An Example: Automated vs. Desk Debugging

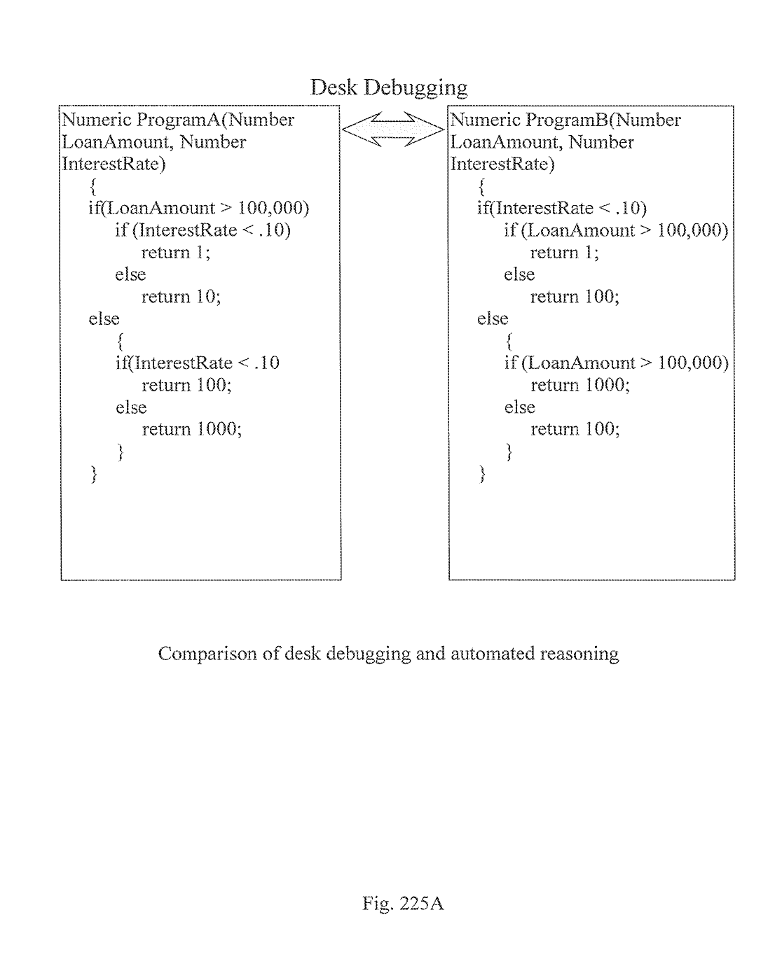

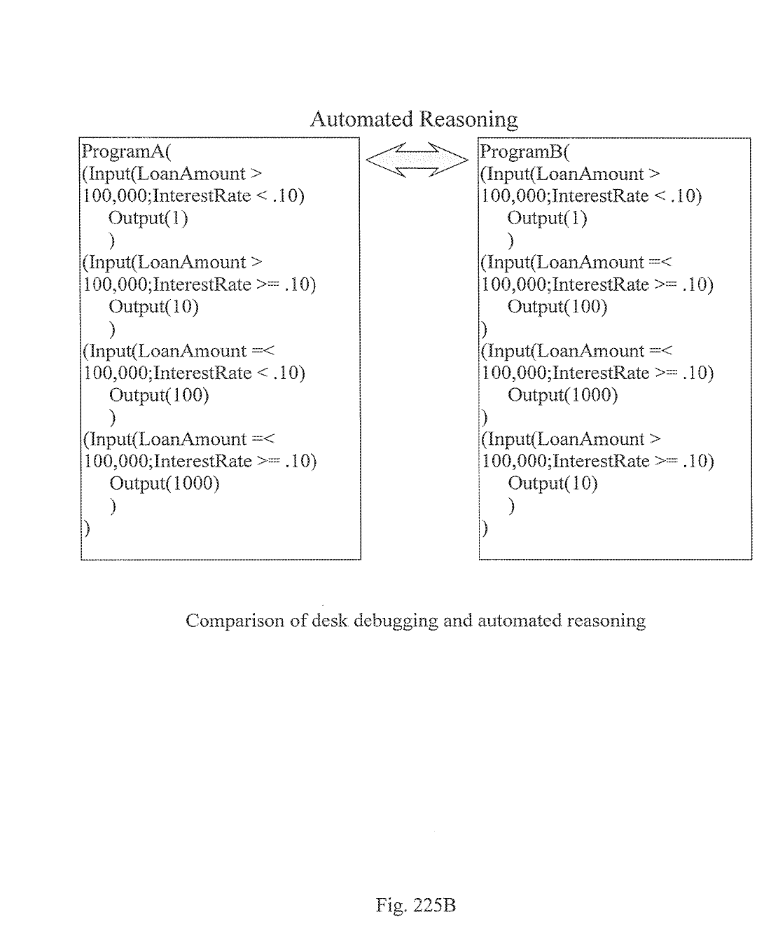

An exemplary Reasoning Service in the home mortgage industry is used here to help clarify the aspects of Comparison and to demonstrate how the Comparison method operates in conjunction with the Semantic Model (FIOSM). In this example, Comparison is employed in the ioSemantics Model to automate a common desk-debugging task, and is discussed herein with reference to FIGS. 225A and 225B. FIG. 225A presents the specifics of the desk-debugging task, and FIG. 225B presents the Automated Reasoning that is part of certain embodiments of the ioSemantics invention.

The code depicted on the left of FIG. 225A differs from the code depicted on the right only in if-then-else structure. On the left, “loan amount” is presented first, and on the right, “interest rate” is presented first. This is a syntactic difference. The semantics (input-output behavior) of both programs are depicted in the Automated Reasoning illustrated in FIG. 225B.

There are tools in the software industry that can analyze the syntax of these two programs and discern the syntactic difference, i.e., the lexical differences in the structure of the text. However, the current state-of-the-art requires a programmer to address the issue of semantics. Automated software processes are not available to perform the task of semantic differentiation. A programmer must look at the two sets of code to accurately determine that the code is semantically the same. Currently, there are no commercially available software tools that can analyze these differences and reach that same conclusion. While the actual semantic comparison is relatively easy for the example code, for commercially useful programs of thousands if not tens of thousands of lines or more, the task is difficult, time consuming, expensive and error prone.

In contrast, in FIG. 225B, the Automated Reasoning capabilities of the ioSemantics embodiments of the present invention utilize corresponding Semantic Models and allow embodiments employing automated reasoning techniques to determine that the two programs are semantically equivalent, that is, that they have the same input-output behavior.

The difference between FIG. 225A and FIG. 225B is that desk debugging requires a human to determine that the two programs are semantically equivalent. In the case of automated reasoning, a machine-borne or automated method (Comparison) can reach the same conclusion.

Comparison

The foundation for comparison in at least one embodiment is set subsumption semantics, based in set theory. The comparison is based on viewing logical semantics as sets, with a fundamental operation of “subset,” as presented in this statement:
SemanticModel(ProgramA)⊃SemanticModel(ProgramB)

This statement indicates that the Semantic Model (FIOSM) of program B is a subset of the Semantic Model (FIOSM) of Program A. This is equivalent to saying that the behavior of Program B is a subset of the behavior of Program A.

From there, the basic subset operation can be combined into more complex operations. Equivalence in set theory is defined in terms of subset operations, as presented in this statement:

SemanticModel(ProgramA) ⊃SemanticModel(ProgramB) AND
SemanticModel(ProgramB) ⊃SemanticModel(ProgramA)

The high-level definition of the Comparison method, as it is used in the ioSemantics embodiments, is this (“IOPD”=“Input/Output Pattern Definition”):

An FIOSM subset relationship of any two programs, ProgA and ProgB, and their corresponding FIOSM Semantic Models (FIOSMA and FIOSMB) is defined in this fashion:

For two programs ProgA and ProgB, ProgB semantics is a subset of ProgA if and only if:
For each IOPD (IOPD-X) in FIOSMB, there exists an IOPD (IOPD-Y) in FIOSMA for which IOPD-X's input pattern describes a subset of IOPD-Y's input pattern

### AND

For each IOPD in FIOSMA (IOPD-A), for every IOPD in FIOSMB (IOPD-Bs) whose input pattern is a subset of IOPD-A, the output pattern for IOPD-B is a subset of the output pattern of IOPD-A.

In assessing the effectiveness of the analytic approach taken, it must be clear that, not only can a Semantic Model be generated for any program written in an FIOSM compatible language, but also the Comparison operation can be done on two Semantic Models created in that fashion, such that the subset operation is complete and correct. This approach to comparison of software semantics is unique.

Implementation Example

A detailed example demonstrates the difference between syntactic and semantic differences and equivalences. This exemplary section shows a detailed example of comparison using a set-theoretic Comparison approach according to an embodiment of the ioSemantics Tools, system and methods. The example builds upon the FIOSM Comparison definition and example provided in reference to FIGS. 225A and 225B.

Syntactic Difference/Semantic Equivalence

This example provides both the source code input that precedes semantic model generation, and the resultant Semantic Model that follows it, for two sample programs, InterestRateA and InterestRateB.

The source code for the InterestRateA example is this:

```
Numeric InterestRateA (Number LoanAmount, Number DebtRatio , Number PropertyValue)
{
  if (LoanAmount > PropertyValue * 0.80)
  {
if (LoanAmount > 100,000)
      {
      if (DebtRatio < .20)
        return 0.06;
      else
        return 0.07;
      }
    else
      {
      if (DebtRatio < .20)
        return 0.04;
      else
        return 0.05;
      }
  }
  else
  {
    if (LoanAmount > 100,000)
      {
      if (DebtRatio < .20)
        return 0.065;
      else
        return 0.075;
      }
    else
      {
      if (DebtRatio < .20)
        return 0.045;
      else
        return 0.055;
      }
  }
}
```

Using embodiments of the ioSemantics tools, system and methods, the following FIOSM Semantic Model for this program can be generated:

FlOSM_InterestRateA
(
IOPD(
Input(LoanAmount>PropertyValue*0.80,LoanAmount > 100,000; DebtRatio < .20)
Output(ReturnValue_InterestA=0.06)
)
IOPD(
Input(LoanAmount>PropertyValue*0.80,LoanAmount > 100,000; DebtRatio >= .20)
Output(ReturnValue_InterestA=0.07)
)
IOPD(
Input(LoanAmount>PropertyValue*0.80,LoanAmount <= 100,000; DebtRatio < .20)
Output(ReturnValue_InterestA=0.04)
)
IOPD(
Input(LoanAmount>PropertyValue*0.80,LoanAmount <= 100,000; DebtRatio >= .20)
Output(ReturnValue_InterestA=0.05)
)
IOPD(
Input(LoanAmount<=PropertyValue*0.80,LoanAmount > 100,000; DebtRatio < .20)
Output(ReturnValue_InterestA=0.065)
)
IOPD(
Input(LoanAmount<=PropertyValue*0.80,LoanAmount > 100,000; DebtRatio >= .20)
Output(ReturnValue_InterestA=0.075)
)
IOPD(
Input(LoanAmount<=PropertyValue*0.80,LoanAmount <= 100,000; DebtRatio < .20)
Output(ReturnValue_InterestA=0.045)
)
IOPD(
Input(LoanAmount<=PropertyValue*0.80,LoanAmount <= 100,000; DebtRatio >= .20)
Output(ReturnValue_InterestA=0.055)
)
)

Similarly, this is the source code input for InterestRateB:

```
Numeric InterestRateB (Number LoanAmount, Number DebtRatio , Number PropertyValue)
{
  if (LoanAmount > 100,000)
  {
    if (LoanAmount > PropertyValue * 0.80)
    {
      if (DebtRatio < .20)
return 0.06
      else
        return 0.07
    }
    else
    {
      if (DebtRatio < .20)
        return 0.065;
      else
        return 0.075;
    }
  }
  else
  {
    if (LoanAmount > PropertyValue * 0.80)
      if (DebtRatio < .20)
        return 0.04;
      else
        return 0.05;
      }
    }
    else
    {
      if (DebtRatio < .20)
        return 0.045;
      else
        return 0.055;
      }
    }
  }
```

Using embodiments of the ioSemantics tools, system and methods, the following FIOSM Semantic Model for this program can be generated:

FIOSM_ InterestRateB
(
IOPD(
Input(LoanAmount > 100,000,LoanAmount>PropertyValue*0.80,DebtRatio < .20)
Output(ReturnValue_InterestA=0.06)
)
IOPD(
Input(LoanAmount > 100,000,LoanAmount>PropertyValue*0.80,DebtRatio >= .20)
Output(ReturnValue_InterestA=0.07)
)
IOPD(
Input(LoanAmount > 100,000,LoanAmount<=PropertyValue*0.80,DebtRatio < .20)
Output(ReturnValue_InterestA=0.065)
)
IOPD(
Input(LoanAmount > 100,000,LoanAmount<=PropertyValue*0.80,DebtRatio >= .20)
Output(ReturnValue_InterestA=0.075)
)
IOPD(
Input(LoanAmount <= 100,000,LoanAmount>PropertyValue*0.80,DebtRatio < .20)
Output(ReturnValue_InterestA=0.04)
)
IOPD(
Input(LoanAmount <= 100,000,LoanAmount>PropertyValue*0.80,DebtRatio >= .20)
Output(ReturnValue_InterestA=0.05)
)
IOPD(
Input(LoanAmount <= 100,000,LoanAmount<=PropertyValue*0.80,DebtRatio < .20)
Output(ReturnValue_InterestA=0.045)
)
IOPD(
Input(LoanAmount <= 100,000,LoanAmount<=PropertyValue*0.80,DebtRatio >= .20)
Output(ReturnValue_InterestA=0.055)
)
)

Both programs in the example take the same input and produce the same output. InterestRateA and InterestRateB are syntactically different; that is to say, a syntactic or lexical comparison of
their text shows them to be different. However, they are semantically equivalent. Although their If-then-else structure is “nested” differently, they are identical from an input-output semantics perspective.

High-Level Process Analysis

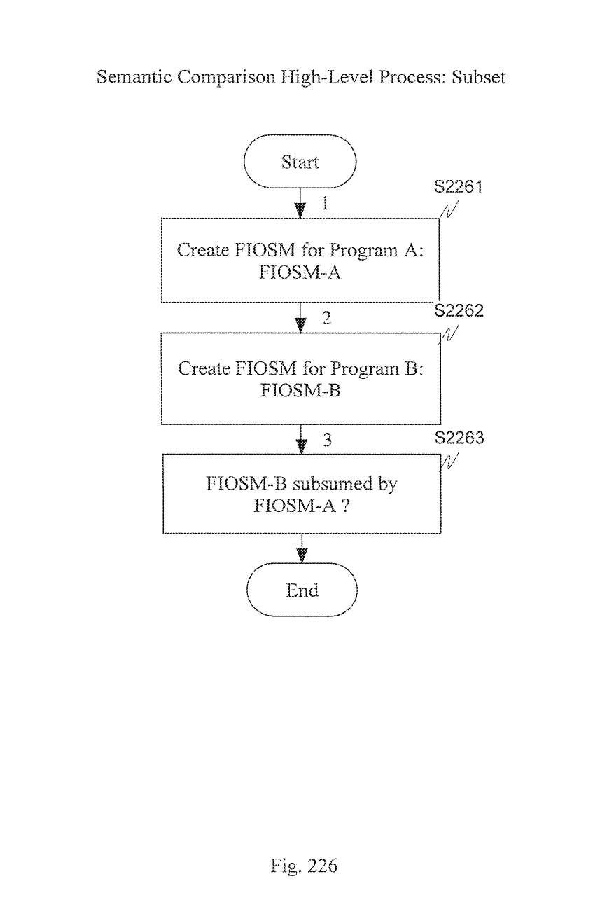

Using the set-theoretic subsumption for comparison, the semantic equivalence can be determined by an automated method. FIG. 226 depicts an exemplary methodology.

To determine whether the semantics of Program B is subsumed by the behavior of Program A:
Generate/create an FIOSM for Program A: FIOSM-A (Step S2261)
Generate/create an FIOSM for Program B: FIOSM-B (Step S2262)
Apply the FIOSM (Semantic Model) Comparison to determine if FIOSM-B is a subset of FIOSM-A and vice versa. (Step S2263)
   The model generation process is described hereinbefore. The final step, which utilizes an embodiment of Semantic Model (FIOSM) comparison, is described in detail below.

Note: As discussed previously, showing equivalence of program function involves merely applying this process twice:
Verify that Program B is subsumed by Program A
Verify that Program A is subsumed by Program B
   If #1 and #2 are verified, then Program A and Program B are semantically equivalent.

Mechanics of Comparison

In creating the ability to conduct the comparison described above, one can build a detailed mechanism that makes it possible to implement the above Comparison definition in a straightforward fashion. The task is to show the processes that connect the data types, data elements, data expressions, and IOPDs with the FIOSM Comparison.

Pattern Match: Subset Data Expressions

Data types—The pattern match can handle both enumerable data types and non-enumerable data types.

For enumerable data types, that is, sets, the result is determined by a finite comparison of the set. One enumerates the membership in the subset, and verifies that each member exists in the proposed superset.

For non-enumerable data types, one generally cannot test by finite comparison, since the sets are not finite. Typically, for such data types there are algebraic methods such as Fourier Elimination or approximation methods that can practically satisfy the subset testing.
Fourier Elimination (used in the examples) can be used in embodiments to resolve subset tests for numeric data types where the numeric calculations are limited to linear (first-order) calculations. For higher order calculations, a combination of algebraic and Numeric Methods can be used in other embodiments to achieve the same goal, to a practical level of precision.

Data elements interaction—Some data types allow multiple data elements to appear in a single data expression. In these cases, it may be necessary to include a “closure” of all related data expressions to determine the subsumption relationship of a single data element.

The example program and its numeric data type are an example of this type. The data expression test of “LoanAmount >PropertyValue*0.080” makes the valid sets “LoanAmount” and “PropertyValue” dependent on each other.

In the example, the dependency is resolved using the Fourier Elimination method although other suitable methods can be utilized in variations and other embodiments.

Converting Subset Testing to Consistency Testing.

Converting subset testing to consistency testing is a method to convert subset testing to consistency testing in the following fashion:
A subset test “A∩B” is equivalent to inconsistency of “˜A AND B.” This is a well-known tautology in logic and set theory. If the formula “˜A AND B” is proven inconsistent, then B describes a subset of A.
   This tautology is typically used in tandem with methods like Fourier Elimination to convert a subset test into a test of algebraic inconsistency. This is illustrated in the next section.

Example Numeric Subset Process

The example programs, InterestRateA and InterestRateB above, use only the numeric data type, which falls into the more complex non-enumerable category.

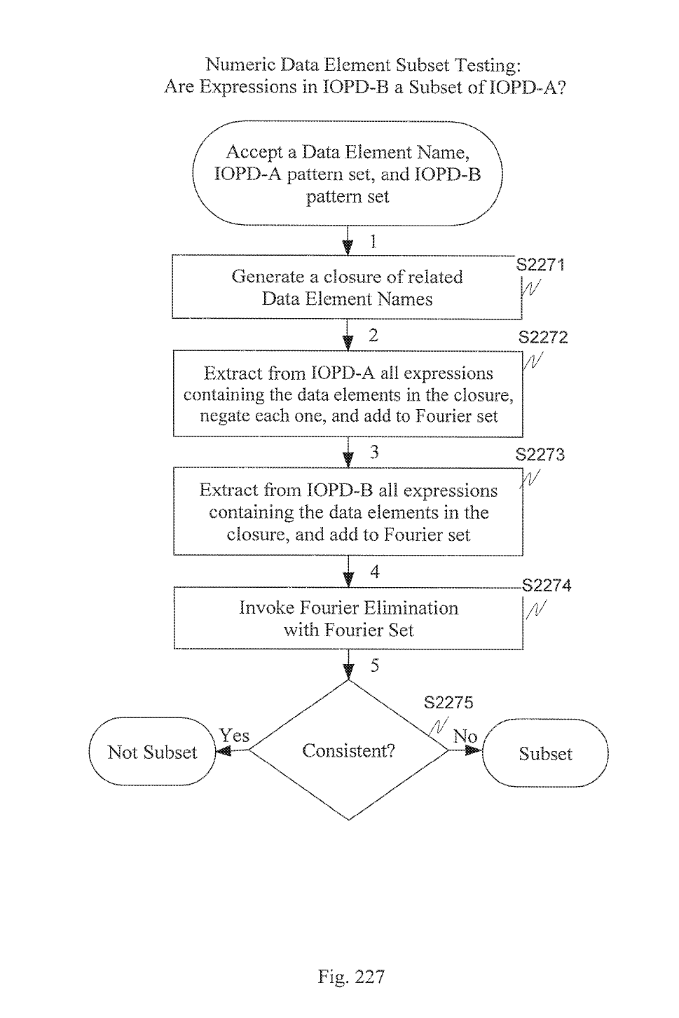

As indicated above, the Fourier Elimination method with conversion to test of inconsistency is used in certain embodiments to implement subset testing. The exemplary process is illustrated in FIG. 227.

The purpose is to test whether, for an arbitrary data element (DE), which occurs in both IOPD-A and IOPD-B, the set described for DE in IOPD-B is a subset of the set described for IOPD-A. The steps in the process are numbered in FIG. 227 and are these:
Generate a “closure” of data element names. This means that there is a transitive closure of participating data element names, where two data elements names occur in IOPD-A or IOPD-B. (Step S2271)
Each data expression in IOPD-A that has an occurrence of at least one data element from the closure is negated and added to the Fourier set. (Step S2272)
Each data expression in IOPD-B that has an occurrence of at least one data element from the closure is added to the Fourier set. (Step S2273)
Fourier Elimination is invoked to test the consistency (feasibility) of the resulting system. (Step S2274)
If the result is “consistent” then the set described in IOPD-B is NOT a subset. If the result is “inconsistent” then the subset test is successful. (Step S2275)

Example Numeric Subset: Example

Using the above exemplary method, an example can illustrate by applying the method to InterestA and InterestB, and to the LoanAmount data element:

Consider LoanAmount, and let IOPD-A pattern set equal the input pattern for the first IOPD in FIOSM-A, and let IOPD-B pattern set equal the input pattern for the first IOPD in FIOSM-B. Applying the methodology in FIG. 227:
The closure is {LoanAmount, PropertyValue}
Add {LoanAmount<=PropertyValue*0.80, LoanAmount<=100,000} to the Fourier set
Add {LoanAmount >100,000, LoanAmount>PropertyValue*0.80} to the Fourier set Invoke Fourier Elimination

The result is inconsistent, so the data expressions in the IOPD-B pattern set are indeed a subset of those in the IOPD-A pattern set

IOPD Pattern Match and Consistency

The next operation is to determine pattern matching of pattern sets in the comparison of two IOPDs, IOPD-A and IOPD-B. “Pattern matching” is equivalent to subset comparison, i.e., if the input pattern of IOPD-B is a subset of input pattern of IOPD-A, then the pattern matches. “Output consistent” is also equivalent to pattern matching, i.e., if the output pattern of IOPD-B is a subset IOPD-A then the output is consistent.

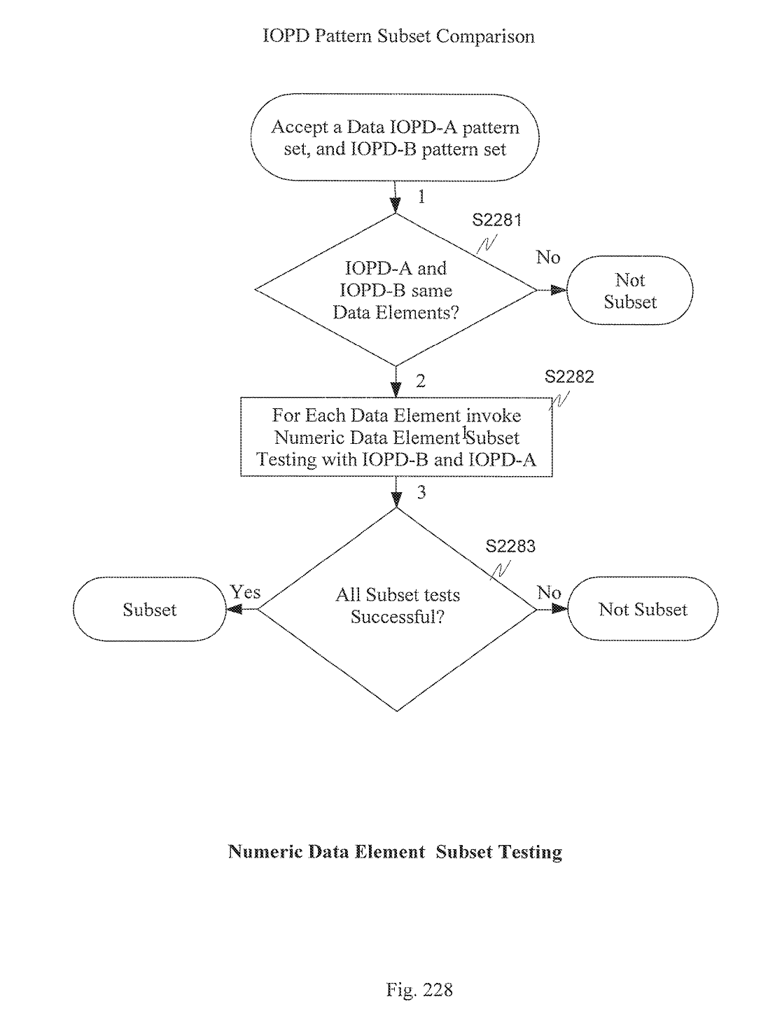

Both of these processes can be tested with the same process illustrated in FIG. 228. As FIG. 228 illustrates, the operations to take in the comparison are:
If both IOPD patterns do not contain the same data elements, then there cannot be a subset relationship. (Step S2281)
Test each of the data elements in IOPD-B using the Numeric Comparison Process defined above. (Step S2282)
If all data elements IOPD-B are proven in Step 2282 to be subsets, then the overall pattern is a subset. (Step 2283)

FIOSM Comparison

At this point, the process to compare the two FIOSMs is clear: simply apply the FIOSM Comparison definition illustrated in FIG. 228, and the Semantic Comparison process is complete.

The exemplary embodiments described herein include, but are not limited to: (i) an automated method of comparing the semantics of two software procedures including but not limited to routines, programs and enterprise systems; (ii) the foregoing method wherein FIOSMs are utilized to facilitate the comparison; (iii) either of the foregoing methods wherein set subsumption semantics, based in set theory is utilized in facilitating the comparison; and (iv) any of the foregoing methods wherein the comparison process includes determining (a) whether a FIOSM of a first software procedure is a subset of the FIOSM of a second software procedure and (b) whether a FOISM of the second software procedure is a subset of the FIOSM of the first software procedure.

Certain embodiments of the ioSemantics invention are revolutionary not only in their ability to generate a Semantic Model, but also for applying Quality Assurance (QA) processes against one (or more) Semantic Models in order to provide verification of a computer program.

The Quality Assurance process is dependent upon related embodiments including the generation of a Finite Input/Output Semantic Model (FIOSM or Semantic Model).

After one (or more) Semantic Models have been generated, reasoning operations utilized in the ioSemantics invention are based on the ability to determine a subset relationship between inputs and outputs of two different programs. This is called a “Subsumption Operation” in mathematical logic and ontology (reference: Handbook of Description Logic). In the context of software comparison, the process is simply called “Comparison.” Embodiments of loSemantics' process for Quality Assurance is also based upon the “Comparison” process disclosed above.

Quality Assurance

Leveraging the “Subsumption Operations” against one (or more) Semantic Models, several processes are illustrated by which the quality of a computer program can be determined.

The first process is called “Regression,” which facilitates the ability to automatically assure that a subset of a computer program's behavior has not changed (i.e., computes the equivalent input-output behavior). This capability has enormous exemplary impact to the field of testing computer programs.

Secondly, and of equal import, this invention defines a process called “Policy”, by which developers of a computer program can define arbitrary policies that ensure that the system always operates in compliance with that defined Policy. The Policy defines a constraint on the input-output behavior of the program or system.

Creation of Semantic Model

This process produces an FIOSM from a source program and is illustrated and fully described and enanbled above. The exemplary source program illustrated below will generate the FIOSM using embodiments of the FIOSM Generation process.

### Source Program

```
Numeric InterestRateA (Number LoanAmount, Number DebtRatio , Number PropertyValue)
{
  if (LoanAmount > PropertyValue * 0.80)
  {
if (LoanAmount > 100,000)
      {
      if (DebtRatio < .20)
        return 0.06;
      else
        return 0.07;
      }
    else
      {
      if (DebtRatio < .20)
        return 0.04;
      else
        return 0.05;
      }
  }
  else
  {
    if (LoanAmount > 100,000)
      {
      if (DebtRatio < .20)
        return 0.065;
      else
        return 0.075;
      }
    else
      {
      if (DebtRatio < .20)
        return 0.045;
      else
        return 0.055;
      }
  }
}
```

Generated FIOSM Semantic Model

FlOSM_InterestRateA
(
IOPD(
Input(LoanAmount>PropertyValue*0.80,LoanAmount > 100,000; DebtRatio < .20)
Output(ReturnValue_InterestA=0.06)
)
IOPD(
Input(LoanAmount>PropertyValue*0.80,LoanAmount > 100,000; DebtRatio >= .20)
Output(ReturnValue_InterestA=0.07)
)
IOPD(
Input(LoanAmount>PropertyValue*0.80,LoanAmount <= 100,000; DebtRatio < .20)
Output(ReturnValue_InterestA=0.04)
)
IOPD(
Input(LoanAmount>PropertyValue*0.80,LoanAmount <= 100,000; DebtRatio >= .20)
Output(ReturnValue_InterestA=0.05)
)
IOPD(
Input(LoanAmount<=PropertyValue*0.80,LoanAmount > 100,000; DebtRatio < .20)
Output(ReturnValue_InterestA=0.065)
)
IOPD(
Input(LoanAmount<=PropertyValue*0.80,LoanAmount > 100,000; DebtRatio >= .20)
Output(ReturnValue_InterestA=0.075)
)
IOPD(
Input(LoanAmount<=PropertyValue*0.80,LoanAmount <= 100,000; DebtRatio < .20)
Output(ReturnValue_InterestA=0.045)
)
IOPD(
Input(LoanAmount<=PropertyValue*0.80,LoanAmount <= 100,000; DebtRatio >= .20)
Output(ReturnValue_InterestA=0.055)
)
)

Regression Set Creation

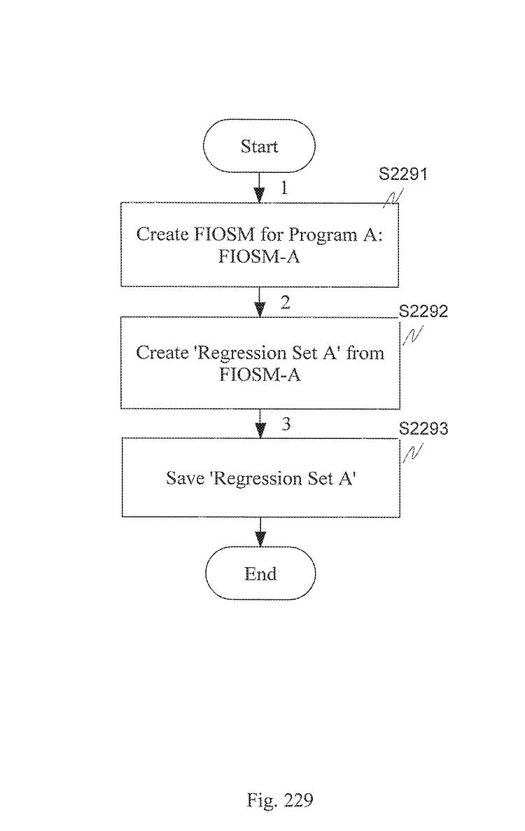

As previously stated, the entire “Regression” process according to the exemplary embodiments is dependant upon generating one (or more) Semantic Models. Once these models have been generated, the “Regression” process may begin. This exemplary process is illustrated in FIG. 229.

As FIG. 229 illustrates, the operations comprise:

Create a Semantic Model (FIOSM) from Program A. This is called FIOSM-A. (Step 2291) Note that this FIOSM has one (or more) Input/Output Pattern Definitions (IOPD's).

Create a “subset” of FIOSM-A to save as the “Regression Set.” This subset is in the form of one (or more) IOPD's. This subset of the program's FIOSM IOPD's will in turn be wrapped into a FIOSM named “Regression Set A.’ (Step S2292)

Save ‘Regression Set A’ to, for example, the computer hard drive or other storage device(s). (Step S2293)

Example

An example process of “creating” a Regression Set is described below. These steps parallel those described in FIG. 229.
Referring to the Generation of the FIOSM Semantic Model above, the first IOPD of the exemplary program is defined as:

IOPD(
Input(LoanAmount>PropertyValue*0.80,LoanAmount > 100,000; DebtRatio < .20)
Output(ReturnValue_InterestA=0.06)
)

To create a “Regression Set” called “Output 1” that will include this IOPD, the process is:
Create a InterestRateA_FIOSM from InterestRateA
Create a Regression Set, by taking the first IOPD (described above), and wrapping it into a new FIOSM, called ‘Output 1’.

FIOSM_Output1
(
IOPD(
Input(LoanAmount>PropertyValue*0.80,LoanAmount > 100,000; DebtRatio < .20)
Output(ReturnValue_InterestA=0.06)
)
)

Save Regression Set ‘Output 1’ (for later usage).

Policy Creation

The Policy defines a global constraint on the input-output behavior of the program or system. According to an exemplary embodiment, a Policy for a particular program or system must have the same input-output signature as the system it references. Referring to the example FIOSM above (FIOSM_InterestRateA), a policy for the exemplary program must have input data elements of LoanAmount, PropertyValue, and DebtRatio. Similar the policy must have ReturnValue_InterestA as output.

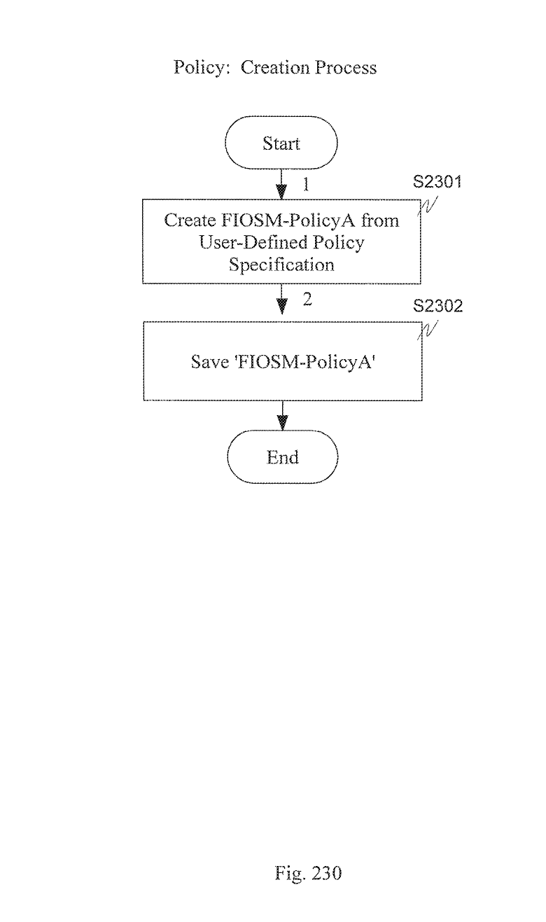

The “Policy” process is dependant upon the ability to generate a Semantic Model. This exemplary process is illustrated in FIG. 230.

As FIG. 2 illustrates, the operations are:
Create a Policy to represent that user-defined policy. Note that this Policy is a FIOSM that has IOPD's consistent with the restrictions defined in relation to the discussion of Subsumption above and the discussed definitions. (Step S2301)
Store the Policy (in the form of a FIOSM) for later use on the computer hard drive or other suitable storage medium whether on a local machine or a remotely located device. (Step S2302)

Policy Example

Referring to the Generated FIOSM Semantic Model above, the exemplary Policy “Policy1” is created by:
1. Create a “Policy” in the format of an FIOSM called “Policy1” with the following format:

FIOSM(
IOPD(
Input(LoanAmount>PropertyValue*0.80,LoanAmount > 100,000; DebtRatio < 0.05)
Output(ReturnValue_InterestA=0.06)
)
)

2. Store this Policy for later usage on the computer hard drive or other suitable storage medium whether on a local machine or a remotely located device.

Quality Testing

After one or more User-defined Policies or Regression Sets have been defined, the system, uses Subsumption/Comparison reasoning to verify that the Policies or Regression Sets are still a valid “theorem” of the system.

Regression Testing

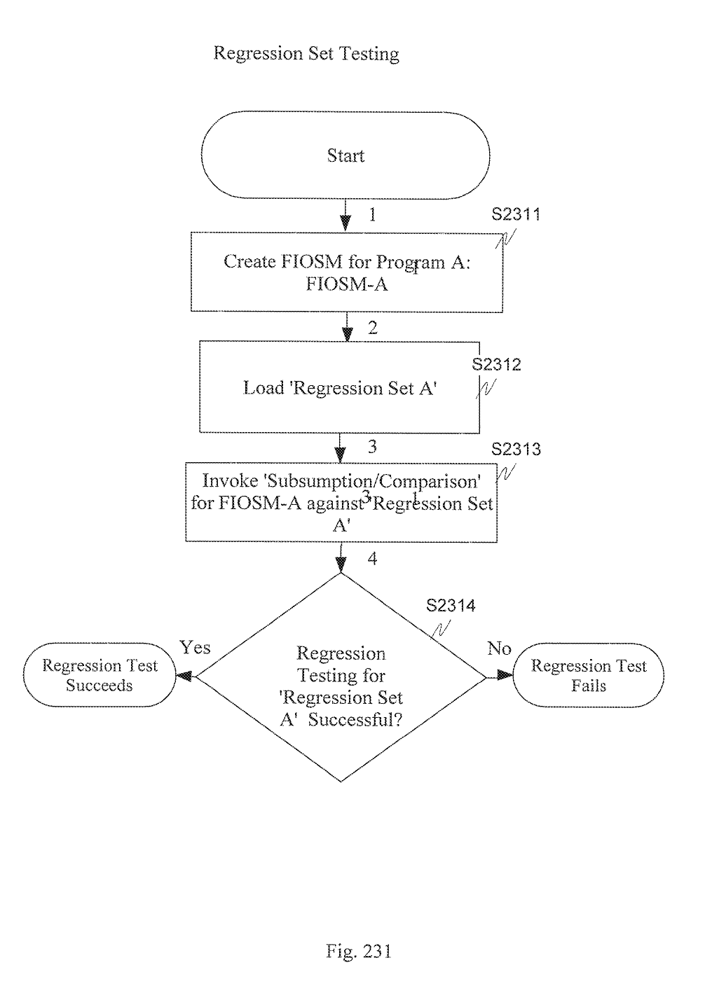

The “Regression Testing” process is illustrated in FIG. 231.
As FIG. 231 illustrates, the operations comprise:
Create a FIOSM (Semantic Model) from Program A. (Step S2311)
The system loads the previously saved FIOSM Regression Set. (Step S2312)
The “Comparison” process is invoked to determine if the Regression Set FIOSM is a behavioral subset of Program A FIOSM. (Step S2313)
If the “Subsumption/Comparison” process returns successfully, then the Regression Test was successful. If Comparison fails, regression testing also fails. (Step S2314)

Example

In the section above (Generated FIOSM Semantic Model), a sample “Regression Set” was created called ‘Output 1.’ Using the saved Regression Set an example process is:
Create a FIOSM (Semantic Model) from InterestRateA. This corresponds to the FIOSM illustrated in the Generated FIOSM Semantic Model.
The system loads the previously saved Regression Set, named ‘Output 1’.
Invoke the “Comparison” process.
The “Subsumption/Comparison” process returns successfully and therefore the Regression Test for ‘Output 1’ was successful.

Policy Testing

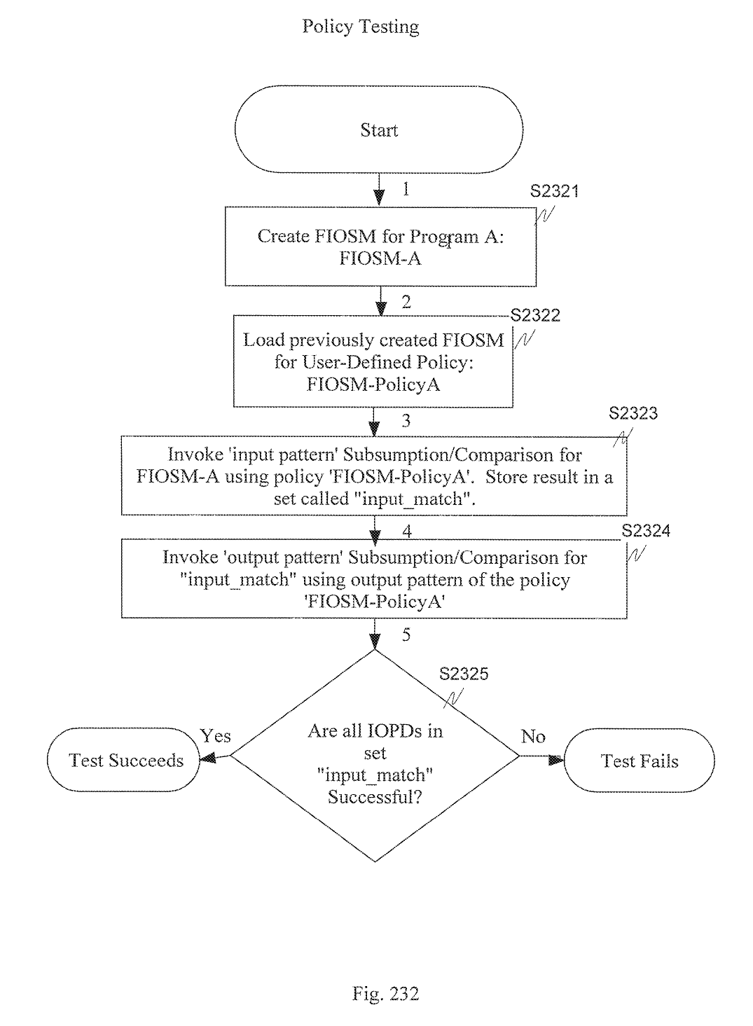

The exemplary “Policy Testing” process is illustrated in FIG. 232.
As FIG. 232 illustrates, the operations comprise:
Create a FIOSM (Semantic Model) from Program A, call it FIOSM_Program_A. (Step S2321)
Load a previously created Policy FIOSM (Semantic Model). (Step S2322)
Invoke the “Subsumption/Comparison” process to determine which IOPDs in FIOSM have input patterns which subsume the input pattern of the Policy FIOSM. Call this set input_match IOPDs. (Step S2323)
Invoke the “Subsumption/Comparison” process to determine which IOPDs in input_match have output patterns have are subsumed by the output pattern of the Policy FIOSM. (Step S2324) If all IOPDs in input_match are successful in step S2324, return success, otherwise return failure. (Step S2325)

Example of Policy Testing

In the above section, a sample “Policy”, called “Policy1” was created.
Create a FIOSM (Semantic Model) from InterestRateA.
Load the previously created Policy called ‘Policy1’.
Invoke the “Subsumption/Comparison” process to determine which IOPDs in FIOSM have input patterns which subsume the input pattern of the Policy FIOSM. This results in an input match set of one IOPD:

IOPD(
Input(LoanAmount>PropertyValue*0.80,LoanAmount > 100,000; DebtRatio < .20)
Output(ReturnValue_InterestA=0.06)
)

Invoke the “Subsumption/Comparison” process to determine which IOPDs in input_match have output patterns have are subsumed by the output pattern of the Policy FIOSM. In this example the single IOPD output pattern is indeed a subset (equivalent) to Policy1's output pattern.

Since all IOPDs in input_match were the process returns success.

Stated another way, and illustrated with a “real world” example problem in the financial industry, the exemplary system below system uses model-based techniques to solve the two classes of software quality assurance problems: policy satisfaction, and regression. In the policy problem, the user wants to know whether a program being evaluated satisfies a constraint, or policy, that is critical in the application domain. In the regression problem, the user wants to know whether a modified version of a program implements the same functionality as some original baseline. These problems are solved using subsumption-based reasoning on semantic models of program behavior, automatically generated for the end user programmer, and also replacing test-case development. The system attains decidability of subsumption reasoning by restricting programming constructs while retaining the expressiveness needed for business applications, like the mortgage pricing application used as an example. The system also allows the end user to browse the semantic model of a program, viewing the behavior of the program flexibly from multiple perspectives.

Programs are complicated. One approach to dealing with this complexity has been the development of programming languages and environments for end users. But while these advances, such as the spreadsheet, make it easier for people to create programs, and easier for people to understand programs, they have not made understanding programs easy enough. In general, the difficulty in understanding what programs do leads to heavy reliance on testing of programs, rather than on analysis. But creating good test cases itself requires a good deal of analysis, and even with good test cases, uncertainty remains about the correctness of the programs that pass the tests.

An alternative approach is to automate the common tasks of program analysis, so that the end user does not have to rely solely on understanding code directly. In ioRules, the exemplary system described here, common questions about programs that arise in software development and maintenance can be answered automatically, with assured correctness. The approach also supports flexible visualization of program function, so that the end user can explore what a program does from multiple viewpoints.

The ioRules approach builds on work on description logic to construct models of program function, and to automatically evaluate the truth value of predicates on these models. Because nontrivial questions about programs are almost never decidable in general (Rice's Theorem, see Wikipedia entry), ioRules restricts the programs that can be modeled. These restrictions do not prevent the system from representing real programs in business domains like finance. To illustrate this, and to show how ioRules supports end user software engineering tasks, here is a non-limiting example application.

ioRules and Mortgage Pricing

The business problem that Pat, a financial specialist, wants to solve is product pricing for a large mortgage bank. The core of the solution is a program that calculates eligibility and pricing for a range of mortgage types. The first portion of Pat's problem is to address eligibility. There are myriad mortgage products that address the needs of differing segments of the consumer population. Examples of these are:

“Conforming” loan products, supported by quasi-government agencies like “Fannie Mae” (FNMA) and “Freddie Mac” (FHLM), are intended to help mainstream Americans to access funding needed for home ownership.

Low-income programs, such as FHA products, address the mortgage needs of Americans earning less than average income.

Veterans Administration (VA) products provide veterans access to special programs that make it easier for them to purchase a home.

“Non-conforming” programs address the needs of the wealthier homebuyers, who purchase more expensive homes and special-use properties.

Each product has rigid eligibility guidelines, that is to say, standards that a particular consumer and his prospective home purchase must satisfy. These standards include:

Which loan amounts are eligible

What percentage of the property's value can be mortgaged

What the consumer's income level must be, and

How good the consumer's credit history must be.

Part of Pat's task is to encode into the system the rules that allow it to offer only the programs appropriate to the consumer's particular mortgage circumstance. Pat's problem must not only address eligibility, but also custom pricing. Lenders are typically concerned about late payment and default on loans. The competition in the mortgage industry encourages lenders to offer pricing breaks to consumers who have good prospects to pay their mortgage payments in a timely and reliable fashion. Similarly, consumers whose prospects of reliable payment are not as good, or who are purchasing properties that are at risk of being harmed by natural disasters, may be asked to pay a slightly higher price relative to others.

Both eligibility and custom pricing are amenable to being modeled and developed in a rules-based fashion.

ioRules development

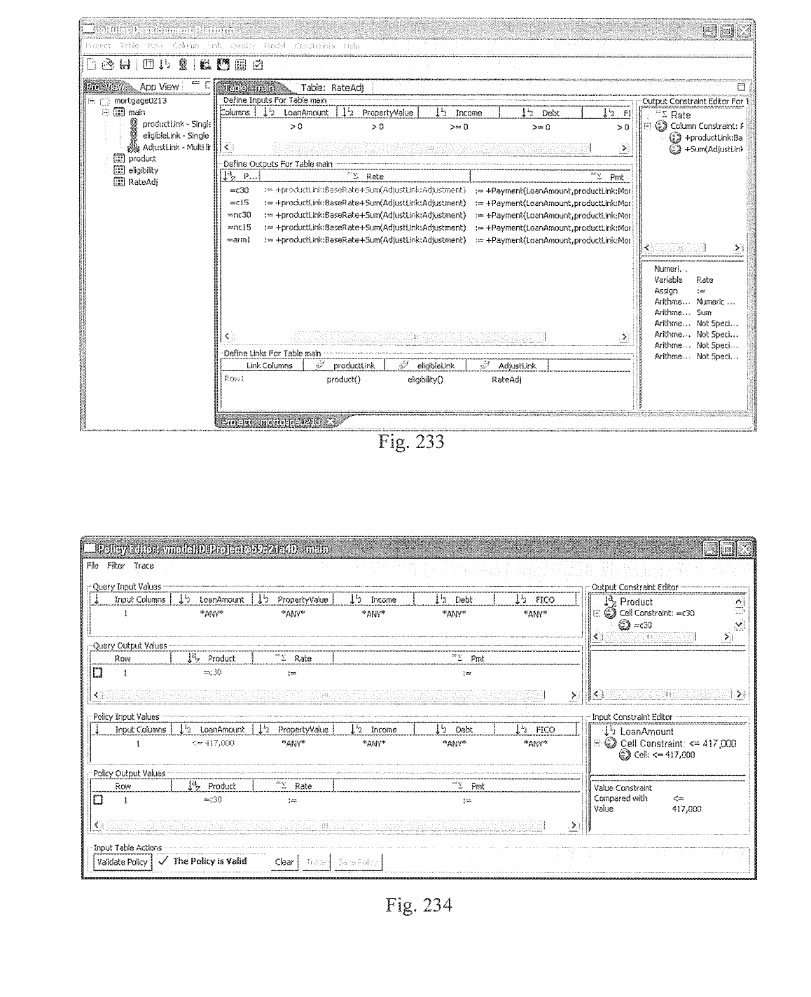

The exemplary ioRules' development interface is designed by analogy to other common business tools: spreadsheets and database query tools. One exemplary development concept is a “table” which is used to specify the rules-based system. The ioRules specification interface is illustrated in FIG. 233.

A table allows Pat to express the input description of the exemplary system, as well as the system's output and calculation behavior. The ioRules system, although visually quite different, can be viewed as having a strong conceptual inheritance from logic-based programming approaches like Prolog. For readers familiar with Prolog, the “input” portion of the ioRules presentation corresponds to the “head” of Prolog predicates, and the “output” portion corresponds to the “tail” portion of Prolog predicates. The columns correspond to the terms in an individual predicate, and rows correspond to repetition of predicates for different potential solutions.

As illustrated in FIG. 233, Pat has defined a “main” table whose input columns are: loan amount, property value, FICO (consumer credit score), consumer income, and consumer debt. These comprise the data needed to determine product eligibility and pricing for consumers.

The output data needed by the consumer to make a mortgage selection are the product type, the rate being paid, and the monthly payment. The output area shows the structure of the output response of the system and the possible solutions. FIG. 233 shows that Pat's system is offering five different potential product choices:

a conforming 30-year mortgage (c30)
a conforming 15-year mortgage (c15)
a non-conforming 30-year mortgage (nc30)
a non-conforming 15-year mortgage (nc15), and
a conforming 1-year adjustable rate mortgage (arm1).

ioRules also allows for the problem to broken into conceptual chunks by allowing tables to be linked together. Pat uses this facility to create three subordinate tables that she links to “main.” They are:

“product” which describes the financial behavior of the product
“eligibility” which defines the eligibility rules of each product, and
“RateAdj” which defines the pricing adjustment rules for each product.

Pat completes her program, and the question needs to be answered whether it is correct? One approach to determining this is to ask if known constraints are satisfied.

Applying a Policy

For example, Pat knows that if her program is correct, no c30 loan should have an amount greater than $417K. She wants to determine whether in fact her program obeys this constraint.

In a traditional software engineering approach, Pat would construct a collection of test cases in an effort to assure herself that her program honors this constraint. In the process, she would have to carry some kind of analysis of her program, trying to identify under what conditions a possible violation could arise. However thorough Pat's analysis is, and assuming that her program passes all of her tests, Pat must still doubt whether there might be some other input data for which a violation would occur.

The exemplary ioRules system allows Pat to work in a different way. First, she asks the system to generate a complete model of her program, capturing all of the possible output-input dependencies in the code. Pat then expresses her constraint, that c30 mortgages must have a loan amount less than or equal to $417K, also using the ioRules editor.

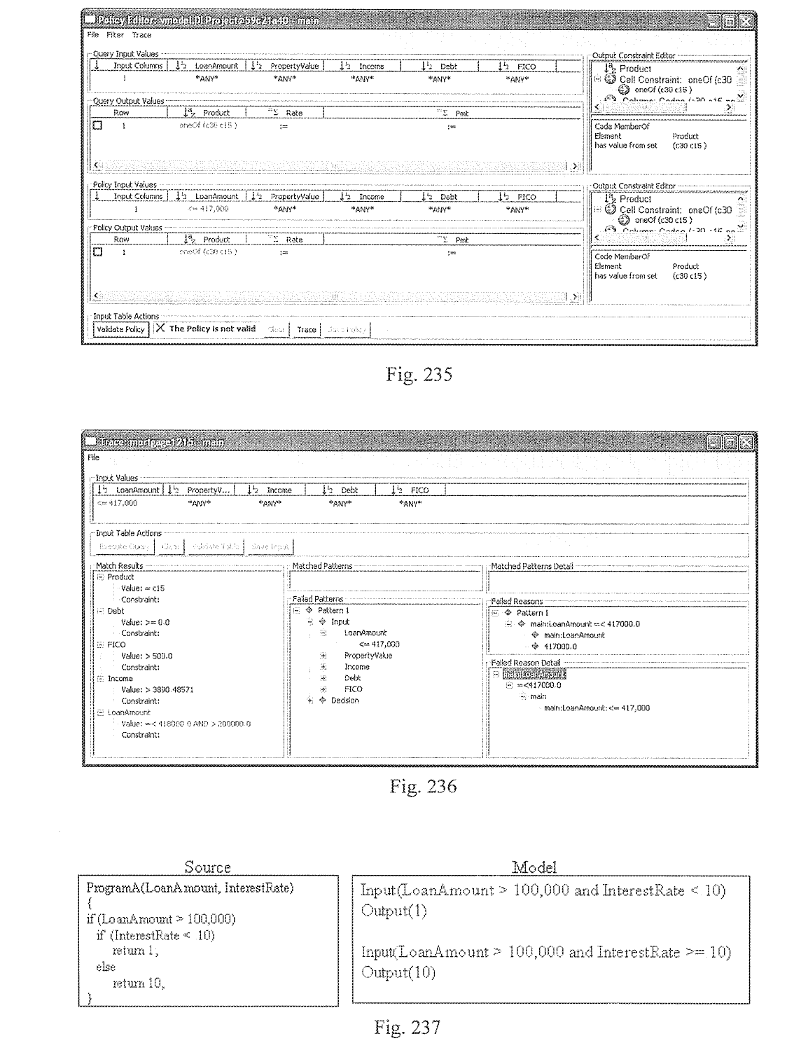

To do this, Pat specifies that Product in the cases she is concerned with is “c30”, and then specifies that the LoanAmount must be less than or equal to $417K. FIG. 2 shows how Pat does this in the ioRules interface. Pat then asks the ioRules system to evaluate the constraint, by clicking the “Validate Policy” button. The system creates a model for the constraint, and determines whether or not the model of her program is subsumed by the model for the constraint, that is, whether the logic of her program implies that the constraint is always satisfied. In this case, the answer is yes. On further reflection, Pat realizes that not just a c30 loan, but any conventional loan, should satisfy the same constraint on loan amount. Pat therefore modifies her policy to include c15 as well as c30, as shown in FIG. 235. Now when Pat asks for the new policy to be validated, the system indicates that it is NOT satisfied. Pat knows that she has an error to correct.

Now Pat can use the ioRules interface to learn WHY the error is occurring. Pat hits the trace button at the bottom of FIG. 235, and opens the window in FIG. 236. This window indicates that the eligibility table specifies a loan limit for c15 of 418K, clearly a mistake. Pat corrects this error and moves to her next task.

ioRules creates a model representation that expresses the semantics (i.e. behavior) of the rules-based system in a fashion that is compatible with a branch of automated reasoning called subsumption reasoning.

FIG. 237 offers an illustration of this semantic model creation by analogy to the common programmer activity of desk-debugging. In desk-debugging, a programmer mentally simulates the execution of a program, following conditional branches, keeping track of the state of the program's variables. Like a programmer, ioRules examines all the possible program paths and data flows to produce a model of all the possible scenarios of program input-output, as shown in the panel on the right of FIG. 237. This model completely describes the correct behavior of the program shown in the panel to the left. This completeness and correctness contrasts with the fundamentally incomplete process of manually creating test cases. Sets of test cases are, in a sense, inexact and incomplete models for any but trivial programs.

Subsumption reasoning automates the proving of a subset relationship between two logical models. In the context of Pat's policy example above, the policy constraint defines a model of behavior, to which the mortgage system must conform. One can restate this in terms of subsumption reasoning: the mortgage system's behavior must be a subset of the behavior defined by the “loan amount limit” policy constraint.

ioRules re-applies the Description Logic approach to rules-based systems. By limiting the expressiveness of the rules-based language to a set of program constructs below the universal machine level, it insures decidability of subsumption reasoning. The reduced set of program constructs is still powerful enough to embody commercial rules-based systems, such as Pat's mortgage eligibility and pricing system.

Regression

The same techniques support Pat, as an end user, in performing other software engineering tasks, including regression. Pat faces a regression problem when she needs to extend a correct program, and needs to be sure that when she does this she doesn't introduce bugs in the part that was already working correctly. In traditional software engineering, Pat would have to construct a regression test suite, a collection of tests that, she hopes, adequately check the behavior of the new program. As noted earlier, creating an adequate test suite requires analysis of her code that Pat, as an end user, probably isn't professionally trained to carry out, it being typically the responsibility of a Quality

Assurance Analyst.

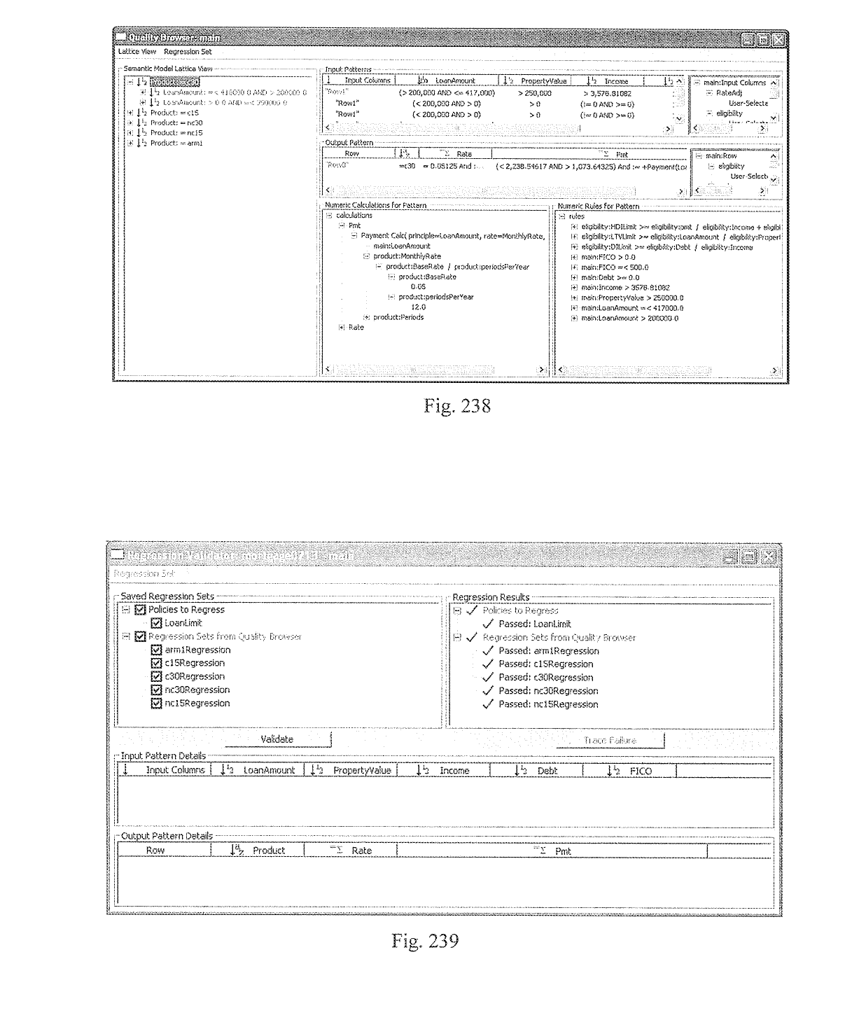

Using the ioRules system, Pat can create not a regression test suite, but a collection of regression models. She does this by selecting portions of the model that capture the behavior of the program for meaningful parts of the overall problem. For example, Pat can choose to divide the model for her program into parts that describe different mortgage products, c15, c30, and so on, as shown in FIG. 238. She asks ioRules to produce a submodel (called a regression model in the interface) for each of these products.

Now suppose Pat needs to add a new product, c50. She needs to be sure that when she adds this product she doesn't introduce errors into the handling of the other products. After she has made the extensions to her program, she uses the Regression Validator function in ioRules. The Validator allows her to choose which regression models she wants to check, and displays the results of the checks, as shown in FIG. 239. In this case, all of the regression checks are satisfied, and Pat can be sure that she hasn't introduced errors in making her extension.

Regression validation requires no new reasoning machinery beyond that used in policy checking, above, apart from the ability to specify a part of a larger model.

Browsing

Pat can use the model that ioRules produces to perform other, less well structured tasks, as well. The system offers a browse mode, which allows Pat to explore the model from many viewpoints. In fact, Pat used the browsing capability to specify the submodels that she needed for her regression task. She can use the same interface for other purposes.

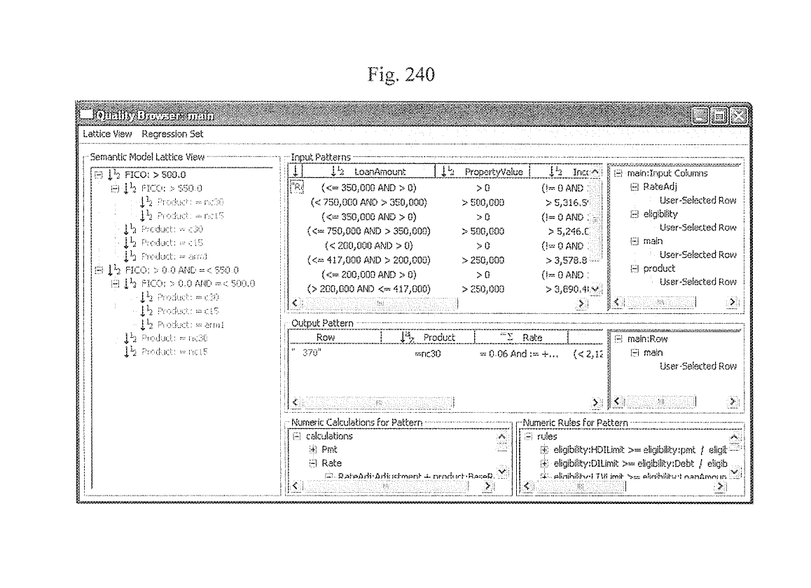

Suppose Pat is concerned about customers with weak credit, and how her program handles them. Instead of dividing the functionality of her program by mortgage product, she can divide it by FICO, a creditworthiness score used in the mortgage industry. FIG. 238 showed a view of the model for Pat's program organized by Product. By selecting Lattice View and specifying “New”, Pat sees a list of quantities that her program operates on. She chooses FICO and Product, and gets the new view of her model shown in FIG. 240.

In this view Pat can see that her program divides the range of FICO scores at 0, 500, and 550, which makes sense to her. She can also see what products are available in each FICO range, though the reasoning is not completely trivial, because the FICO range is not divided into disjoint subranges in the display. Pat can work out that for customers with FICO between 0 and 500, products c30, c15, and arm1 are offered; for customers with FICO between 500 and 550, nc30 and nc15 are also available, and for customers with FICO greater than 550, the same products are offered, that is, there is no difference, in terms of available products, among customers with FICO of 500 or above, though other results, such as interest, could change.

As the example shows, end users can answer important questions about their program automatically. While they have to understand their problem, one exemplary advantage is that they do not have to do the analysis of their program required to create test cases in non-automated approaches. Further, they do not suffer the uncertainty about correctness that reliance on testing leaves, even when test cases are automatically generated.

The various embodiments and variations thereof illustrated in the accompanying Figures and/or in the totality of this document are merely exemplary and are not meant to limit the scope of the invention. It is to be appreciated that numerous variations of the invention have been contemplated as would be obvious to one of ordinary skill in the art with the benefit of this disclosure. Additionally, while certain features may be categorized under one or more headings, it is to be appreciated that the feature(s) described under a particular heading may be used in associating with other portions of the specification and/or feature(s) described herein.

While the above described methodology has been discussed in relation to a particular sequence of events, it should be appreciated that minor changes to this sequence can occur without materially effecting the operation of the invention.

The above-described system and methodology, as has been indicated herein, can be implemented on a computing device, such as a personal computer, server, dedicated computing device, distributed processing system, or the like, or a separately programmed general purpose computer. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as a discrete element circuit, a programmable logic device such as a PLD, PLA, FPGA, PAL, or the like, in fuzzy logic, artificial intelligence and/or neural networks. In general, any device(s) or module capable of implementing a state machine that is in turn capable of implementing the processes described herein can be used to implement this invention.

Furthermore, the disclosed methods may readily implemented in software using, for example, object or object-oriented software development environments that provide portable source code that can be used on a variety of computer or workstation platforms. The disclosed system and methodology may also be implemented partially or fully in hardware using standard logic circuits or, for example, a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein can be readily implemented in hardware and/or software using any suitable systems, means, structures, devices and/or the functionality stored on an appropriate information storage medium, by those of ordinary skill in the applicable art from the functional description provided herein and with a basic general knowledge of the computer and software arts.

While the embodiments illustrated herein may show the various components collocated, it is to be appreciated that the various components of the system can be located at distant portions of a distributed network, such as a telecommunications network and/or the Internet and/or within a dedicated communications network. Thus, it should be appreciated that the various components can be combined into one or more devices or collocated on a particular node of a distributed network, such as a telecommunications network. As will be appreciated from the description, and for reasons of computational efficiency, the components can be arranged at any location within a distributed network without affecting the operation of the system.

Furthermore, it should be appreciated that various links connecting elements can be wired or wireless links, or a combination thereof, or any known or later developed element(s) that is capable of supplying and/or communicating data to and from the connected elements.

While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1-26. (canceled)

27. A method for quality control of software comprising:
generating a parse tree;
generating a code path set based on the parse tree;
generating a path data model set using the code path set; and
generating a finite input/output semantic model (FIOSM) from the path data model set.

28. The method of claim 27, wherein the generation of a finite input/output semantic model dictates that the software has a completely decidable data flow.

29. The method of claim 27, wherein said generating a parse tree comprises parsing the source code of a software procedure.

30. The method of claim 27, wherein said generating a parse tree comprises parsing the source code of a software program.

31. (canceled)

32. A method of software quality assurance comprising analyzing one or more finite input output semantic models of computer code.

33. The method of claim 32, wherein the analyzing comprises a regression process.

34. The method of claim 32, wherein the analyzing comprises determining policy compliance.

35. The method of claim 33, wherein the regression process comprises:
determining a finite input output semantic model for a first portion of computer code;
determining a subset of the finite input output semantic model, wherein the subset is one or more input/output pattern definitions; and
determining a finite input output semantic model for the one or more input/output pattern definitions.

36. The method of claim 34, wherein a policy provides a constraint on input/output behavior of the computer code.

37. The method of claim 36, wherein the policy has an input/output signature corresponding to the computer code it references.

38. The method of claim 34, wherein policy creation comprises:
determining a policy to represent at least one user-defined policy, wherein the policy is a finite input output semantic model; and
storing the policy.

39. The method of claim 33, further comprising testing the regression process including:
obtaining the finite input output semantic model for the computer code;
loading a regression set;
comparing the finite input output semantic model for the computer code and the regression set; and
determining whether the regression set is a subset of the finite input output semantic model for the computer code.

40. The method of claim 34, wherein testing of policy compliance comprises:
obtaining the finite input output semantic model for the computer code;
loading a policy;
performing a comparison process to determine which input/output pattern definitions in the finite input output semantic model have input patterns which subsume an input pattern of a policy finite input output semantic model; and
performing a comparison process to determine which input/output patterns from the above comparison process are subsumed by an output pattern of the finite input output semantic model for the policy.

41. A method of software quality assurance comprising analyzing one or more finite input output semantic models of a program in cooperation with a policy validation user interface.

42-46. (canceled)
